(19) United States
(12) Patent Application Publication
(10) Pub. No.: US 2025/0299255 A1
(43) Pub. Date: Sep. 25, 2025

(54) SYSTEMS AND METHODS FOR PROVIDING PROCESS AUTOMATION AND ARTIFICIAL INTELLIGENCE, MARKET AGGREGATION, AND EMBEDDED MARKETPLACES FOR A TRANSACTIONS PLATFORM

(71) Applicant: STRONG FORCE TX PORTFOLIO 2018, LLC, Fort Lauderdale, FL (US)

(72) Inventors: Charles Howard CELLA, Fort Lauderdale, FL (US); Andrew CARDNO, Fort Lauderdale, FL (US); Taylor CHARON, Fort Lauderdale, FL (US); Andrew BUNIN, Fort Lauderdale, FL (US); Teymour EL-TAHRY, Fort Lauderdale, FL (US); Ben GOODMAN, Fort Lauderdale, FL (US); Andrew SHARP, Fort Lauderdale, FL (US); Brent BLIVEN, Fort Lauderdale, FL (US); Jenna PARENTI, Fort Lauderdale, FL (US); Leon FORTIN, JR., Fort Lauderdale, FL (US); Brad KELL, Fort Lauderdale, FL (US); Andrew LOCKE, Fort Lauderdale, FL (US)

(73) Assignee: STRONG FORCE TX PORTFOLIO 2018, LLC, Fort Lauderdale, FL (US)

(21) Appl. No.: 19/028,863

(22) Filed: Jan. 17, 2025

Related U.S. Application Data
(63) Continuation of application No. PCT/US2023/028546, filed on Jul. 25, 2023.
(60) Provisional application No. 63/392,083, filed on Jul. 25, 2022.
(60) Provisional application No. 63/381,546, filed on Oct. 28, 2022.
(60) Provisional application No. 63/428,953, filed on Nov. 30, 2022.

(51) Int. Cl. G06Q 40/04; G06N 20/00

(52) U.S. Cl. CPC G06Q 40/04; G06N 20/00

(57) ABSTRACT

A method and a system for providing at least one of a process automation and artificial intelligence (PAAI), a market aggregation, or an embedded marketplace relating to transactions are disclosed. In particular, a method and a system for automation of transactions in a transaction environment (e.g., marketplace or a set of marketplaces) are disclosed. A method and a system for managing transactions in a transaction environment (e.g., marketplace or a set of marketplaces) are disclosed. A method and a system for automating processing of transactions in a transaction environment (e.g., marketplace or a set of marketplaces) are disclosed. A method and a system for automated orchestration of a transaction environment (e.g., marketplace or a set of marketplaces) are disclosed. A method and a system for augmenting of services in a transaction environment (e.g., marketplace or a set of marketplaces) are disclosed.

### CROSS-REFERENCE TO RELATED APPLICATIONS

This application is a bypass continuation of International Application No. PCT/US2023/028546, filed Jul. 25, 2023, which claims priority to: U.S. Provisional Patent Application No. 63/392,083, filed Jul. 25, 2022; U.S. Provisional Patent Application No. 63/381,546, filed Oct. 28, 2022, and U.S. Provisional Patent Application No. 63/428,953, filed Nov. 30, 2022. Each patent application referenced above is hereby incorporated by reference as if fully set forth herein in its entirety.

### FIELD

The present disclosure relates to transaction platforms, and more particularly relates to transaction platforms that include systems for at least one of process automation and artificial intelligence, market aggregation, or embedded marketplaces.

### BACKGROUND

Marketplaces provide a range of critical functions for their stakeholders, including the ability to find counterparties who are willing to engage in transactions involving a wide range of asset classes. Among other things, exchange transactions allow parties to unlock liquidity, execute financial strategies (such as with arbitrage), manage risk (such as with options and futures contracts), aggregate capital, convert value from one asset class to another, participate in gains from trade, influence behavior, and obtain insight (such as from data streams about transactions). Successful marketplaces like the New York Stock Exchange (NYSE) and the Chicago Mercantile Exchange (CME) are fundamental components of the global economy, and new exchanges emerge regularly for new categories. Exchanges rely increasingly on information technology infrastructure capabilities for a wide range of core capabilities for trading, presentation, execution, reporting, analytics, reconciliation and other functions, including distributed storage, caching, high speed networking, algorithmic trading, big data, data integration, modeling and analytics, robotic process automation, distributed ledger technologies (DLTs), smart contracts, real-time data collection, search, asset digitization and others. There exists a need in the art to provide intelligent orchestration of markets for a broad and expanding range of asset classes and involving an increasingly diverse set of stakeholders.

### SUMMARY

According to an example embodiment, a computer-implemented method for automation of transactions in a transaction environment (e.g., a marketplace or a set of marketplaces) is disclosed. The method may include generating, by a processing system, a digital twin of a marketplace, where the digital twin may be a digital representation of a structure of the marketplace, the structure being representative of a set of entities of the marketplace including items in the marketplace, parties in the marketplace, and one or more Internet of Things (IoT) devices associated with each one of the parties in the marketplace. The method further comprises determining, by the processing system, a utilization of one of the items by at least one of the parties or a requirement of one of the items by one of the parties by implementing the digital twin of the marketplace. The method further comprises facilitating, by the processing system, a transaction between at least one of the parties providing the at least one of the items and at least one of the parties having the utilization or the requirement of the at least one of the items based on the determination.

In example embodiments, the digital twin of the marketplace is generated based on information about: the items in the marketplace including at least one of: current price of each of the items, price history of each of the items, order history of each of the items, or a service history of each of the items; the parties in the marketplace including at least one of: transaction history of each of the parties, risk profile of each of the parties, social data of the each of the parties, or item portfolio of the each of the parties; and the one or more IoT devices associated with each one of the parties in the marketplace include at least one of: a type of each of the one or more IoT devices or a capability of each of the one or more IoT devices.

In example embodiments, the method further comprises placing, by the processing system, an order for a given item for a given party based on the determination; and processing, by the processing system, an automated payment for the order using payment details of the given party.

In example embodiments, the method further comprises forecasting, by the processing system, price of a given item in the marketplace for a defined time period by implementing the digital twin of the marketplace.

In example embodiments, the method further comprises estimating, by the processing system, a lowest forecasted price of the given item in the defined time period based on the forecasting; determining, by the processing system, a price difference between the lowest forecasted price of the given item and a current price of the given item; and scheduling, by the processing system, an order for the given item for a time corresponding to the lowest forecasted price of the given item, if the price difference is above a defined price threshold.

In example embodiments, the method further comprises defining, by the processing system, at least one of the time period or the price threshold based on an urgency of the requirement of the given item by implementing the digital twin of the marketplace.

In example embodiments, the method further comprises determining, by the processing system, a current demand of a given item in the marketplace, by implementing the digital twin of the marketplace; and adapting, by the processing system, a current price of the given item in the marketplace based on the current demand thereof.

In example embodiments, the method further comprises determining, by the processing system, a forecasted demand of a given item in the marketplace, by implementing the digital twin of the marketplace; and generating, by the processing system, an inventory forecast for one or more of the parties providing the given item based on the forecasted demand thereof.

In example embodiments, the method further comprises determining, by the processing system, a forecasted demand of a given item in the marketplace, by implementing the digital twin of the marketplace; and generating, by the processing system, a procurement order for the given item on behalf of one or more of the parties providing the given item to consumers to one or more of the parties manufacturing the given item, based on the forecasted demand thereof.

In example embodiments, the digital twin of the marketplace is a web of digital twins of the parties in the marketplace.

According to another example embodiment, a computing system for automation of transactions in a transaction environment (e.g., a marketplace or a set of marketplaces) is disclosed. The system comprises a processing system. The processing system is configured to generate a digital twin of a marketplace, wherein the digital twin is a digital representation of a structure of the marketplace, the structure being representative of a set of entities of the marketplace including items in the marketplace, parties in the marketplace, and one or more IoT devices associated with each one of the parties in the marketplace. The processing system is further configured to determine a utilization of one of the items by at least one of the parties or a requirement of one of the items by one of the parties by implementing the digital twin of the marketplace. The processing system is further configured to facilitate a transaction between at least one of the parties providing the at least one of the items and at least one of the parties having the utilization or the requirement of the at least one of the items based on the determination.

In example embodiments, the processing system is configured to generate the digital twin of the marketplace based on information about: the items in the marketplace including at least one of: current price of each of the items, price history of each of the items, order history of each of the items, or a service history of each of the items; the parties in the marketplace including at least one of: transaction history of each of the parties, risk profile of each of the parties, social data of the each of the parties, or item portfolio of the each of the parties; and the one or more IoT devices associated with each one of the parties in the marketplace include at least one of: a type of each of the one or more IoT devices or a capability of each of the one or more IoT devices.

In example embodiments, the processing system is further configured to: place an order for a given item for a given party based on the determination; and process an automated payment for the order using payment details of the given party.

In example embodiments, the processing system is further configured to: forecast price of a given item in the marketplace for a defined time period by implementing the digital twin of the marketplace.

In example embodiments, the processing system is further configured to: estimate a lowest forecasted price of the given item in the defined time period based on the forecasting; determine a price difference between the lowest forecasted price of the given item and a current price of the given item; and schedule an order for the given item for a time corresponding to the lowest forecasted price of the given item, if the price difference is above a defined price threshold.

In example embodiments, the processing system is further configured to: define at least one of the time period and the price threshold based on an urgency of the requirement of the given item by implementing the digital twin of the marketplace.

In example embodiments, the processing system is further configured to: determine a current demand of a given item in the marketplace, by implementing the digital twin of the marketplace; and adapt a current price of the given item in the marketplace based on the current demand thereof.

In example embodiments, the processing system is further configured to: determine a forecasted demand of a given item in the marketplace, by implementing the digital twin of the marketplace; and generate an inventory forecast for one or more of the parties providing the given item based on the forecasted demand thereof.

In example embodiments, the processing system is further configured to: determine a forecasted demand of a given item in the marketplace, by implementing the digital twin of the marketplace; and generate a procurement order for the given item on behalf of one or more of the parties providing the given item to consumers to one or more of the parties manufacturing the given item, based on the forecasted demand thereof.

In example embodiments, the digital twin of the marketplace is a web of digital twins of the parties in the marketplace.

According to another example embodiment, a computer-implemented method for automation of transactions in a transaction environment is disclosed. The method may include generating, by a processing system, a digital twin of the transaction environment. The digital twin may be a digital representation of a structure of the transaction environment. The structure may have a set of entities and a set of relationships among the entities of the transaction environment. The method may include determining, by the processing system, a utilization of the set of entities by implementing the digital twin of the transaction environment; and facilitating, by the processing system, a transaction between at least one of the set of entities based on the determination.

In example embodiments, the set of entities includes items in the transaction environment, parties in the transaction environment, and one or more IoT devices associated with each one of the parties in the transaction environment. The utilization of the set of entities may include the utilization of one of the items by at least one of the parties or a requirement of one of the items by one of the parties by implementing the digital twin of the transaction environment; and where the facilitating the transaction may include facilitating the transaction between at least one of the parties providing the at least one of the items and at least one of the parties having the utilization or the requirement of the at least one of the items.

In example embodiments, digital twin of the transaction environment may be a representation that indicates at least one of: a type of entity, a transactor entity, a regulatory authority entity, or a regulatory relationship between entities.

According to another example embodiment, a computer-implemented method for managing transactions in a transaction environment (e.g., a marketplace or a set of marketplaces) is disclosed. The method comprises generating, by a processing system, a digital twin of a marketplace, wherein the digital twin is a digital representation of a structure of the marketplace, the structure having a set of entities of the marketplace including one or more of transactors in the marketplace, transaction authorities in the marketplace, lending authorities in the marketplace, and regulatory authorities in the marketplace. The method further comprises generating, by the processing system, an artificial intelligence (AI) model trained on transactions data for the marketplace. The method further comprises monitoring, by the AI model, the transactions, in near real-time, in the marketplace. The method further comprises defining, by the processing system, a rules framework in the digital twin for executing transactions between each of the one or more of the transactors in the marketplace, the transaction authorities in the marketplace, the lending authorities in the marketplace, and the regulatory authorities in the marketplace based on the monitoring, by implementing the AI model.

In example embodiments, the method further comprises implementing, by the processing system, the AI model in an edge computing arrangement associated with the marketplace, to enable the AI model to monitor the transactions, in near real-time, in the marketplace.

In example embodiments, the method further comprises determining, by the processing system, at least one pattern in the transactions for each of the one or more transactors in the marketplace by implementing the AI model; and generating, by the processing system, a risk profile for each of the one or more transactors in the marketplace based on the determined at least one pattern therefor.

In example embodiments, the method further comprises executing, by the processing system, a given transaction between a given transactor and a given transaction authority based on the risk profile of the given transactor and the defined rules framework therebetween.

In example embodiments, the method further comprises determining, by the processing system, at least one pattern in the transactions for each of the one or more transactors in the marketplace by implementing the AI model; and generating, by the processing system, a lending profile for each of the one or more transactors in the marketplace based on the determined at least one pattern therefor.

In example embodiments, the method further comprises executing, by the processing system, a given transaction between a given transactor and a given lending authority based on the lending profile of the given transactor and the defined rules framework therebetween.

In example embodiments, the method further comprises determining, by the processing system, at least one pattern in the transactions for each of the one or more transactors in the marketplace by implementing the AI model; and generating, by the processing system, a compliance profile for each of the one or more transactors in the marketplace based on the determined at least one pattern therefor.

In example embodiments, the method further comprises executing, by the processing system, a given transaction between a given transactor and a given regulatory authority based on the compliance profile of the given transactor and the defined rules framework therebetween.

In example embodiments, the method further comprises sharing, by the processing system, via a distributed leger, a profile of each of the one or more transactors with at least one of: the one or more transaction authorities in the marketplace, the one or more lending authorities in the marketplace, or the one or more regulatory authorities in the marketplace.

In example embodiments, the method further comprises obtaining, by the processing system, a permission from each of the one or more transactors to share the corresponding profile with the at least one of: the one or more transaction authorities in the marketplace, the one or more lending authorities in the marketplace, or the one or more regulatory authorities in the marketplace.

In example embodiments, the method further comprises masking, by the processing system, one or more defined personal details from the corresponding profile for each of the one or more transactors before sharing.

In example embodiments, the method further comprises tokenizing, by the processing system, a given transaction in the marketplace; and embedding, by the processing system, the tokenized given transaction in a given smart contract.

In example embodiments, the method further comprises utilizing, by the processing system, a smart contract for automation of a given transaction based on instructions defined therein between any two of the one or more transactors in the marketplace, the one or more transaction authorities in the marketplace, the one or more lending authorities in the marketplace, or the one or more regulatory authorities in the marketplace by implementing the AI model.

In example embodiments, the method further comprises implementing, by the processing system, the AI model to regulate one or more individual AI models associated with the one or more of the transaction authorities in the marketplace, the lending authorities in the marketplace, and the regulatory authorities in the marketplace.

In example embodiments, the method further comprises allowing, by the processing system, for a human user to flag a given transaction of the monitored transactions; training, by the processing system, the AI model based on the flagged given transaction; and implementing, by the processing system, the AI model to flag one or more of the monitored transactions based on the training thereof.

In example embodiments, the method further comprises analyzing, by the processing system, the monitored transactions to determine at least one of: a size, a structure, or a timing of issuing credit to a given transactor by a given lending authorities in the marketplace.

In example embodiments, the method further comprises generating, by the processing system, a verifiable action token for the transactions in the marketplace.

In example embodiments, the method further comprises defining, by the processing system, for the lending authorities, a credit line to be provided each of the transactors in the marketplace based on the transactions data and the monitoring of the transactions in the marketplace, by implementing the AI model.

In other example embodiments, a computing system for managing transactions in a transaction environment (e.g., a marketplace or a set of marketplaces) is disclosed. The system comprises a processing system. The processing system is configured to generate a digital twin of a marketplace, wherein the digital twin is a digital representation of a structure of the marketplace, the structure having a set of entities of the marketplace including one or more of transactors in the marketplace, transaction authorities in the marketplace, lending authorities in the marketplace, and regulatory authorities in the marketplace. The processing system is further configured to generate an artificial intelligence (AI) model trained on transactions data for the marketplace. The processing system is further configured to monitor, by the AI model, the transactions, in near real-time, in the marketplace. The processing system is further configured to define a rules framework in the digital twin for executing transactions between each of the one or more of the transactors in the marketplace, the transaction authorities in the marketplace, the lending authorities in the marketplace, and the regulatory authorities in the marketplace based on the monitoring, by implementing the AI model.

In example embodiments, the processing system is further configured to implement the AI model in an edge computing arrangement associated with the marketplace, to enable the AI model to monitor the transactions, in near real-time, in the marketplace.

In example embodiments, the processing system is further configured to determine at least one pattern in the transactions for each of the transactors in the marketplace by implementing the AI model; and generate a risk profile for each of the transactors in the marketplace based on the determined at least one pattern therefor.

In example embodiments, the processing system is further configured to execute a given transaction between a given transactor and a given transaction authority based on the risk profile of the given transactor and the defined rules framework therebetween.

In example embodiments, the processing system is further configured to determine at least one pattern in the transactions for each of the transactors in the marketplace by implementing the AI model; and generate a lending profile for each of the transactors in the marketplace based on the determined at least one pattern therefor.

In example embodiments, the processing system is further configured to execute a given transaction between a given transactor and a given lending authority based on the lending profile of the given transactor and the defined rules framework therebetween.

In example embodiments, the processing system is further configured to determine at least one pattern in the transactions for each of the transactors in the marketplace by implementing the AI model; and generate a compliance profile for each of the transactors in the marketplace based on the determined at least one pattern therefor.

In example embodiments, the processing system is further configured to execute a given transaction between a given transactor and a given regulatory authority based on the compliance profile of the given transactor and the defined rules framework therebetween.

In example embodiments, the processing system is further configured to share via a distributed leger, a profile of each of the one or more transactors with at least one of: the one or more transaction authorities in the marketplace, the one or more lending authorities in the marketplace, or the one or more regulatory authorities in the marketplace.

In example embodiments, the processing system is further configured to obtain a permission from each of the one or more transactors to share the corresponding profile with the at least one of: the one or more transaction authorities in the marketplace, the one or more lending authorities in the marketplace, or the one or more regulatory authorities in the marketplace.

In example embodiments, the processing system is further configured to mask one or more defined personal details from the corresponding profile for each of the transactors before sharing.

In example embodiments, the processing system is further configured to tokenize a given transaction in the marketplace; and embed the tokenized given transaction in a given smart contract.

In example embodiments, the processing system is further configured to utilize a smart contract for automation of a given transaction based on instructions defined therein between any two of the one or more transactors in the marketplace, one or more the transaction authorities in the marketplace, the one or more lending authorities in the marketplace, or the one or more regulatory authorities in the marketplace by implementing the AI model.

In example embodiments, the processing system is further configured to implement the AI model to regulate one or more individual AI models associated with the one or more of the transaction authorities in the marketplace, the lending authorities in the marketplace, or the regulatory authorities in the marketplace.

In example embodiments, the processing system is further configured to allow for a human user to flag a given transaction of the monitored transactions; train the AI model based on the flagged given transaction; and implement the AI model to flag one or more of the monitored transactions based on the training thereof.

In example embodiments, the processing system is further configured to analyze the monitored transactions to determine at least one of: a size, a structure, or a timing of issuing credit to a given transactor by a given lending authorities in the marketplace.

In example embodiments, the processing system is further configured to generate a verifiable action token for the transactions in the marketplace.

In example embodiments, the processing system is further configured to define for the lending authorities, a credit line to be provided each of the transactors in the marketplace based on the transactions data and the monitoring of the transactions in the marketplace, by implementing the AI model.

According to another example embodiment, a computer-implemented method for managing transactions in a transaction environment is disclosed. The method may include generating, by a processing system, a digital twin of the transaction environment. The digital twin may be a digital representation of a structure of the transaction environment. The structure may have a set of entities and a set of relationships among the entities of the transaction environment. The method may include generating, by the processing system, an artificial intelligence (AI) model trained on transactions data for the transaction environment; monitoring, by the AI model, the transactions, in near real-time, in the transaction environment; and defining, by the processing system, a rules framework in the digital twin for executing transactions in the transaction environment based on the monitoring by implementing the AI model.

In example embodiments, the set of entities may include one or more of parties in the transaction environment, transaction authorities in the transaction environment, lending authorities in the transaction environment, or regulatory authorities in the transaction environment. The defining of the rules framework may include defining of the rules framework in the digital twin for executing transactions between each of the at least one or more of the parties in the transaction environment, the transaction authorities in the transaction environment, the lending authorities in the transaction environment, or the regulatory authorities in the transaction environment based on the monitoring, by implementing the AI model.

In example embodiments, the digital representation may indicate at least one of: a type of entity, a transactor entity, a regulatory authority entity, or a regulatory relationship between entities.

According to another example embodiment, a computer-implemented method for automating processing of transactions in a transaction environment (e.g., a marketplace or a set of marketplaces) is disclosed. The method comprises generating, by a processing system, an artificial intelligence (AI) model trained on a set of user interactions related to one or more transactions in response to corresponding one or more events in a marketplace. The method further comprises configuring, by the processing system, a robotic process automation (RPA) module to mimic the user interactions by implementing the AI model. The method further comprises monitoring, by the processing system, in near real-time, events in the marketplace. The method further comprises implementing, by the processing system, the RPA module to automatically process a transaction in response to a given event in the marketplace, as per the monitoring, by providing corresponding instructions complementary to one or more user interactions otherwise required therefor.

In example embodiments, the method further comprises implementing, by the processing system, the RPA module to generate an invoice, for a given party delivering one or more items to a party receiving the one or more items, for a given event of completion of delivery of the one or more items.

In example embodiments, the method further comprises implementing, by the processing system, the RPA module to process a registration of a person for a given event of completion of a predefined age for the person.

In example embodiments, the method further comprises implementing, by the processing system, the RPA module to process a trade for at least one of: buying, selling, or shorting a security from a security exchange in the marketplace for a given event of a trigger price.

In example embodiments, the method further comprises implementing, by the processing system, the RPA module to process a purchase of an insurance for a trade to be executed from an insurance exchange in the marketplace for a given event of price volatility.

In example embodiments, the method further comprises implementing, by the processing system, the RPA module to trigger an insurance claim for an event of an accident.

According to another example embodiment, a computing system for automating processing of transactions in a transaction environment (e.g., a marketplace or a set of marketplaces) is disclosed. The system comprises a processing system. The processing system is configured to generate an artificial intelligence (AI) model trained on a set of user interactions related to one or more transactions in response to corresponding one or more events in a marketplace. The processing system is further configured to configure a robotic process automation (RPA) module to mimic the user interactions by implementing the AI model. The processing system is further configured to monitor in near real-time, events in the marketplace. The processing system is further configured to implement the RPA module to automatically process a transaction in response to a given event in the marketplace, as per the monitoring, by providing corresponding instructions complementary to one or more user interactions otherwise required therefor.

In example embodiments, the processing system is further configured to implement the RPA module to generate an invoice, for a given party delivering one or more items to a party receiving the one or more items, for a given event of completion of delivery of the one or more items.

In example embodiments, the processing system is further configured to implement the RPA module to process a registration of a person for a given event of completion of a predefined age for the person.

In example embodiments, the processing system is further configured to implement the RPA module to process a trade for at least one of: buying, selling, or shorting a security from a security exchange in the marketplace for a given event of a trigger price.

In example embodiments, the processing system is further configured to implement the RPA module to process a purchase of an insurance for a trade to be executed from an insurance exchange in the marketplace for a given event of price volatility.

In example embodiments, the processing system is further configured to implement the RPA module to trigger an insurance claim for an event of an accident.

According to another example embodiment, a computing system for automating processing of transactions in a transaction environment is disclosed. The system may include: a processing system configured to: generate an artificial intelligence (AI) model trained based on one or more transactions in response to corresponding one or more events in a marketplace; configure a robotic process automation (RPA) module by implementing the AI model; monitor in near real-time, events in the marketplace; and implement the RPA module to automatically process a transaction in response to a given event in the marketplace, as per the monitoring, by providing corresponding instructions based on one or more recommendations.

According to another example embodiment, a computer-implemented method for automated orchestration of a transaction environment (e.g., a marketplace or a set of marketplaces) is disclosed. The method comprises obtaining, by a processing system, information about different items in a marketplace, including information about at least one attribute associated with each of the different items. The method further comprises aggregating, by the processing system, one or more items in the marketplace into corresponding one or more aggregate assets based, at least in part, on the respective at least one attribute associated therewith. The method further comprises generating, by the processing system, a digital twin representing the marketplace with the one or more aggregate assets. The method further comprises facilitating, by the processing system, one or more transactions for each one of the one or more aggregate assets independent of another one or more aggregate assets in the marketplace.

In example embodiments, the method further comprises providing, by the processing system, a set of interface elements for a party to access at least one of the one or more aggregate assets therein independent of the other one or more aggregate assets.

In example embodiments, the method further comprises: recording, by the processing system, user interactions related to assigning of corresponding values, as the at least one attribute, to the different items in the marketplace and to aggregating of the different items as the one or more aggregate assets in the marketplace in relation to the assigned values thereto; configuring, by the processing system, a robotic process automation (RPA) module to mimic the user interactions related to the assigning of corresponding values to the different items and the aggregating of the different items into the one or more aggregate assets; and implementing, by the processing system, the RPA module to automatically assign value to a given item in the marketplace and to automatically aggregate one or more given items into one or more aggregate assets based on the automatically assigned values thereto in the marketplace.

In example embodiments, the method further comprises: recording, by the processing system, user interactions related to translation of values, as one of the one or more transactions, of the one or more aggregate assets from one of exchanges in the marketplace to another one of the exchanges in the marketplace; configuring, by the processing system, a robotic process automation (RPA) module to mimic the user interactions related to the translation of values of the one or more aggregate assets; and implementing, by the processing system, the RPA module to automatically translate a first value of a given aggregated asset represented in a first exchange into a second value of the given aggregated asset for representation in a second exchange.

In example embodiments, the method further comprises: recording, by the processing system, user interactions related to generation of a token, as one of the one or more transactions, for the one or more aggregate assets as represented in one of exchanges in the marketplace to be transferred to be representation in another one of the exchanges in the marketplace; configuring, by the processing system, a robotic process automation (RPA) module to mimic the user interactions related to the generation of the token for the one or more aggregate assets; and implementing, by the processing system, the RPA module to automatically generate a token for a given aggregated asset represented in a first exchange to transfer the given aggregated asset for representation in a second exchange.

In example embodiments, the method further comprises: recording, by the processing system, user interactions related to generation of digital representations of a set of rights, as one of the one or more transactions, for the one or more aggregate assets in the marketplace based on at least one of a set of smart contracts and a set of terms and conditions related to the different aggregate assets; configuring, by the processing system, a robotic process automation (RPA) module to mimic the user interactions related to the generation of digital representations of a set of rights for the one or more aggregate assets; and implementing, by the processing system, the RPA module to automatically generate a digital representation of a set of rights for a given aggregate asset in the marketplace based on at least one of the set of smart contracts and the set of terms and conditions related thereto.

In example embodiments, the method further comprises: recording, by the processing system, user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace; configuring, by the processing system, a robotic process automation (RPA) module to mimic the user interactions related to the orchestrating a set of transaction workflows for the one or more aggregate assets; and implementing, by the processing system, the RPA module to automatically orchestrate a set of transaction workflows for a given aggregated asset by initiating a set of first actions in the at least one of the exchanges in response to triggering of a set of second actions in the at least one other exchange in the marketplace.

In example embodiments, the method further comprises: recording, by the processing system, user interactions related to adjusting of timing of delivery, as one of the one or more transactions, for the one or more aggregate assets based on at least one of a transaction parameter or a network performance parameter in the marketplace; configuring, by the processing system, a robotic process automation (RPA) module to mimic the user interactions related to the adjusting of timing of delivery for the one or more aggregate assets; and implementing, by the processing system, the RPA module to automatically adjust timing of delivery for a given aggregated asset based on at least one of the transaction parameter or the network performance parameter in the marketplace.

In example embodiments, the method further comprises: recording, by the processing system, user interactions related to determining of demand, as the at least one attribute, for the different items in the marketplace and to aggregating of the different items as the one or more aggregate assets in the marketplace in relation to the demand thereof; configuring, by the processing system, a robotic process automation (RPA) module to mimic the user interactions related to the determining of demand for the different items and the aggregating of the different items into the one or more aggregate assets; and implementing, by the processing system, the RPA module to automatically determine demand for a given item in the marketplace and to automatically aggregate one or more given items into one or more aggregate assets based on the automatically determined demands thereof in the marketplace.

In example embodiments, the method further comprises: recording, by the processing system, user interactions related to curation of a set of micro-transactions for the one or more aggregate assets and processing of the curated set of micro-transactions as a single transaction for the one or more aggregate assets, as one of the one or more transactions, in the marketplace; configuring, by the processing system, a robotic process automation (RPA) module to mimic the user interactions related to the curation of the set of micro-transactions for the one or more aggregate assets and processing of the curated set of micro-transactions as the single transaction for the one or more aggregate assets; and implementing, by the processing system, the RPA module to automatically curate a set of micro-transactions for a given aggregated asset and process the automatically curated set of micro-transactions as a single transaction in the marketplace.

According to another example embodiment, a system for automated orchestration of a transaction environment (e.g., a marketplace or a set of marketplaces) is disclosed. The system comprises a processing system. The processing system is configured to obtain information about different items in a marketplace, including information about at least one attribute associated with each of the different items. The processing system is further configured to aggregate one or more items in the marketplace into corresponding one or more aggregate assets based, at least in part, on the respective at least one attribute associated therewith. The processing system is further configured to generate a digital twin representing the marketplace with the one or more aggregate assets. The processing system is further configured to facilitate one or more transactions for each one of the one or more aggregate assets independent of another one or more aggregate assets in the marketplace.

In example embodiments, the processing system is further configured to provide a set of interface elements for a party to access at least one of the one or more aggregate assets therein independent of the other one or more aggregate assets.

In example embodiments, the processing system is further configured to: record user interactions related to assigning of corresponding values, as the at least one attribute, to the different items in the marketplace and to aggregating of the different items as the one or more aggregate assets in the marketplace in relation to the assigned values thereto; configure a robotic process automation (RPA) module to mimic the user interactions related to the assigning of corresponding values to the different items and the aggregating of the different items into the one or more aggregate assets; and implement the RPA module to automatically assign value to a given item in the marketplace and to automatically aggregate one or more given items into one or more aggregate assets based on the automatically assigned values thereto in the marketplace.

In example embodiments, the processing system is further configured to: record user interactions related to translation of values, as one of the one or more transactions, of the one or more aggregate assets from one of exchanges in the marketplace to another one of the exchanges in the marketplace; configure a robotic process automation (RPA) module to mimic the user interactions related to the translation of values of the one or more aggregate assets; and implement the RPA module to automatically translate a first value of a given aggregated asset represented in a first exchange into a second value of the given aggregated asset for representation in a second exchange.

In example embodiments, the processing system is further configured to: record user interactions related to generation of a token, as one of the one or more transactions, for the one or more aggregate assets as represented in one of the exchanges in the marketplace to be transferred to be representation in another one of the exchanges in the marketplace; configure a robotic process automation (RPA) module to mimic the user interactions related to the generation of the token for the one or more aggregate assets; and implement the RPA module to automatically generate a token for a given aggregated asset represented in a first exchange to transfer the given aggregated asset for representation in a second exchange.

In example embodiments, the processing system is further configured to: record user interactions related to generation of digital representations of a set of rights, as one of the one or more transactions, for the one or more aggregate assets in the marketplace based on at least one of a set of smart contracts and a set of terms and conditions related to the different aggregate assets; configure a robotic process automation (RPA) module to mimic the user interactions related to the generation of digital representations of a set of rights for the one or more aggregate assets; and implement the RPA module to automatically generate a digital representation of a set of rights for a given aggregate asset in the marketplace based on at least one of the set of smart contracts and the set of terms and conditions related thereto.

In example embodiments, the processing system is further configured to: record user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace; configure a robotic process automation (RPA) module to mimic the user interactions related to the orchestrating a set of transaction workflows for the one or more aggregate assets; and implement the RPA module to automatically orchestrate a set of transaction workflows for a given aggregated asset by initiating a set of first actions in the at least one of the exchanges in response to triggering of a set of second actions in the at least one other exchange in the marketplace.

In example embodiments, the processing system is further configured to: record user interactions related to adjusting of timing of delivery, as one of the one or more transactions, for the one or more aggregate assets based on at least one of a transaction parameter or a network performance parameter in the marketplace; configure a robotic process automation (RPA) module to mimic the user interactions related to the adjusting of timing of delivery for the one or more aggregate assets; and implement the RPA module to automatically adjust timing of delivery for a given aggregated asset based on at least one of the transaction parameter or the network performance parameter in the marketplace.

In example embodiments, the processing system is further configured to: record user interactions related to determining of demand, as the at least one attribute, for the different items in the marketplace and to aggregating of the different items as the one or more aggregate assets in the marketplace in relation to the demand thereof; configure a robotic process automation (RPA) module to mimic the user interactions related to the determining of demand for the different items and the aggregating of the different items into the one or more aggregate assets; and implement the RPA module to automatically determine demand for a given item in the marketplace and to automatically aggregate one or more given items into one or more aggregate assets based on the automatically determined demands thereof in the marketplace.

In example embodiments, the processing system is further configured to: record user interactions related to curation of a set of micro-transactions for the one or more aggregate assets and processing of the curated set of micro-transactions as a single transaction for the one or more aggregate assets, as one of the one or more transactions, in the marketplace; configure a robotic process automation (RPA) module to mimic the user interactions related to the curation of the set of micro-transactions for the one or more aggregate assets and processing of the curated set of micro-transactions as the single transaction for the one or more aggregate assets; and implement the RPA module to automatically curate a set of micro-transactions for a given aggregated asset and process the automatically curated set of micro-transactions as a single transaction in the marketplace.

According to another example embodiment, a computer-implemented method for augmenting of services in a transaction environment (e.g., a marketplace or a set of marketplaces) is disclosed. The method comprises generating, by a processing system, a digital twin of a marketplace, wherein the digital twin is a digital representation of a set of parties in the marketplace and a set of services available in the marketplace. The method further comprises monitoring, by the processing system, service transactions between the set of parties in the marketplace. The method further comprises analyzing, by the processing system, a nature of a current service transaction by a given party of the set of parties in the marketplace based on the monitoring. The method further comprises determining, by the processing system, by implementing the digital twin, a supplementary service from the set of services related to the current service transaction suitable for the given party based on the nature of the current service transaction.

The method further comprises providing, by the processing system, a recommendation for the supplementary service to the given party.

In example embodiments, the method further comprises: generating, by the processing system, an artificial intelligence (AI) model trained on information about the relationship between different services of the set of services available in the marketplace; and implementing, by the processing system, the AI model to determine the supplementary service from the set of services related to the current service transaction suitable for the given party.

In example embodiments, the method further comprises the supplementary service comprises at least one of: a guarantee service, an insurance service, a loan service, a discount service, a promotion service, a verification service, a validation service, a sponsorship service, a rewards service, a tax service, a fraud alert service, or a compliance service.

In example embodiments, the method further comprises the supplementary service is a value-added service.

In example embodiments, the method further comprises the one of the parties in the set of parties in the marketplace is a consumer comprising at least one of: a person, an enterprise, a machine, a real estate, a manufacturer, or an asset owner.

In example embodiments, the method further comprises the one of the parties in the set of parties in the marketplace is a service provider comprising at least one of: a merchant, a payments provider, a guarantor, an identity manager, an insurer, a banker, a lender, a host, or a presenter.

In example embodiments, the method further comprises the provided set of services in the marketplace are configurable by the service provider.

In example embodiments, the method further comprises analyzing the nature of the current service transaction comprises estimating interconnectedness of other transaction services related to the current service transaction, and wherein the supplementary service is determined based on the estimated interconnectedness of other transaction services.

In example embodiments, the method further comprises analyzing the nature of the current service transaction comprises estimating likeness of other transaction services, related to the current service transaction, by other parties of the set of parties in the marketplace, and wherein the supplementary service is determined based on the estimated likeness of other transaction services.

In example embodiments, the marketplace is a virtual environment.

According to another example embodiment, a system for augmenting of services in a transaction environment (e.g., a marketplace or a set of marketplaces) is disclosed. The system comprises a processing system. The processing system is configured to generate a digital twin of a marketplace, wherein the digital twin is a digital representation of a set of parties in the marketplace and a set of services available in the marketplace. The processing system is further configured to monitor service transactions between the set of parties in the marketplace. The processing system is further configured to analyze a nature of a current service transaction by a given party of the set of parties in the marketplace based on the monitoring. The processing system is further configured to determine, by implementing the digital twin, a supplementary service from the set of services related to the current service transaction suitable for the given party based on the nature of the current service transaction. The processing system is further configured to provide a recommendation for the supplementary service to the given party.

In example embodiments, the processing system is further configured to: generate an artificial intelligence (AI) model trained on information about relationship between different services of the set of services available in the marketplace; and implement the AI model to determine the supplementary service from the set of services related to the current service transaction suitable for the given party.

In example embodiments, the supplementary service comprises at least one of: a guarantee service, an insurance service, a loan service, a discount service, a promotion service, a verification service, a validation service, a sponsorship service, a rewards service, a tax service, a fraud alert service, or a compliance service.

In example embodiments, the supplementary service is a value-added service.

In example embodiments, the one of the parties in the set of parties in the marketplace is a consumer comprising at least one of: a person, an enterprise, a machine, a real estate, a manufacturer, or an asset owner.

In example embodiments, the one of the parties in the set of parties in the marketplace is a service provider comprising at least one of: a merchant, a payments provider, a guarantor, an identity manager, an insurer, a banker, a lender, a host, or a presenter.

In example embodiments, the provided set of services in the marketplace is configurable by the service provider.

In example embodiments, analyzing the nature of the current service transaction comprises estimating interconnectedness of other transaction services related to the current service transaction, and wherein the supplementary service is determined based on the estimated interconnectedness of other transaction services.

In example embodiments, analyzing the nature of the current service transaction comprises estimating likeness of other transaction services, related to the current service transaction, by other parties of the set of parties in the marketplace, and wherein the supplementary service is determined based on the estimated likeness of other transaction services.

In example embodiments, the marketplace is a virtual environment.

These and other features, and characteristics of the present technology, as well as the methods of operation and functions of the related elements of structure and the combination of parts and economies of the manufacturer, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise. A more complete understanding of the disclosure will be appreciated from the description and accompanying drawings and the claims, which follow.

### BRIEF DESCRIPTION OF THE FIGURES

The disclosure and the following detailed description of certain embodiments thereof may be understood by reference to the following figures:

FIG. 1 is a schematic diagram of components of a platform for enabling intelligent transactions in accordance with embodiments of the present disclosure.

FIGS. 2A and 2B are schematic diagrams of additional components of a platform for enabling intelligent transactions in accordance with embodiments of the present disclosure.

FIG. 3 is a schematic diagram of additional components of a platform for enabling intelligent transactions in accordance with embodiments of the present disclosure.

FIG. 4 is a schematic diagram of components of an environment including an intelligent energy and compute facility, a host intelligent energy and compute facility resource management platform, a set of data sources, a set of expert systems, interfaces to a set of market platforms and external resources, and a set of user or client systems and devices in accordance with embodiments of the present disclosure.

FIG. 5 depicts components and interactions of a transactional, financial and marketplace enablement system.

FIG. 6 depicts components and interactions of a set of data handling layers of a transactional, financial and marketplace enablement system.

FIG. 7 depicts adaptive intelligence and robotic process automation capabilities of a transactional, financial and marketplace enablement system.

FIG. 8 depicts opportunity mining capabilities of a transactional, financial and marketplace enablement system.

FIG. 9 depicts adaptive edge computation management and edge intelligence capabilities of a transactional, financial and marketplace enablement system.

FIG. 10 depicts protocol adaptation and adaptive data storage capabilities of a transactional, financial and marketplace enablement system.

FIG. 11 depicts robotic operational analytic capabilities of a transactional, financial and marketplace enablement system.

FIG. 12 depicts a blockchain and smart contract platform for a forward market for access rights to events.

FIG. 13 depicts an algorithm and a dashboard of a blockchain and smart contract platform for a forward market for access rights to events.

FIG. 14 depicts a blockchain and smart contract platform for forward market demand aggregation.

FIG. 15 depicts an algorithm and a dashboard of a blockchain and smart contract platform for forward market demand aggregation.

FIG. 16 depicts a blockchain and smart contract platform for crowdsourcing for innovation.

FIG. 17 depicts an algorithm and a dashboard of a blockchain and smart contract platform for crowdsourcing for innovation.

FIG. 18 depicts a blockchain and smart contract platform for crowdsourcing for evidence.

FIG. 19 depicts an algorithm and a dashboard of a blockchain and smart contract platform for crowdsourcing for evidence.

FIG. 20 is a diagrammatic view illustrating an example user interface of a digital marketplace configured to enable transactions and commerce between various users of the knowledge distribution system according to some embodiments of the present disclosure.

FIG. 21 is a schematic view of an exemplary embodiment of the market orchestration system according to some embodiments of the present disclosure.

FIG. 22 is a schematic view of an exemplary embodiment of the market orchestration system including a marketplace configuration system for configuring and launching a marketplace.

FIG. 23 is a schematic illustrating an example embodiment of a method of configuring and launching a marketplace according to some embodiments of the present disclosure.

FIG. 24 is a schematic view of an exemplary embodiment of the market orchestration system including a robotic process automation system configured to automate internal marketplace workflows based on robotic process automation.

FIG. 25 is a schematic view of an exemplary embodiment of the market orchestration system including an edge device configured to perform edge computation and intelligence.

FIG. 26 is a schematic view of an exemplary embodiment of the market orchestration system including a digital twin system configured to integrate a set of adaptive edge computing systems with a market orchestration digital twin.

FIG. 27 is a schematic view of a digital twin system according to some embodiments.

### Enterprise Access Layer FIGS.

FIG. 28 is a schematic view of an example of an enterprise ecosystem having an enterprise access layer.

FIG. 29 is a schematic view of another example of an enterprise ecosystem having an enterprise access layer.

FIG. 30 is a schematic view of examples of how the enterprise access layer of FIG. 29 may be integrated with portions of an enterprise ecosystem.

FIG. 31 is a schematic view of an example market orchestration system that includes an enterprise access layer.

### Intelligence Services System FIGS.

FIG. 32 is a schematic view of an example of an intelligence services system according to some embodiments.

FIG. 33 is a schematic view of an example of a neural network according to some embodiments.

FIG. 34 is a schematic view of an example of a convolutional neural network according to some embodiments.

FIG. 35 is a schematic view of an example of a neural network according to some embodiments.

FIG. 36 is a diagram of an approach based on reinforcement learning according to some embodiments.

### Market Orchestration Architecture FIGS.

FIG. 37 depicts a block diagram of a market orchestration architecture that integrates cross market exchange methods and systems described herein.

FIG. 38 depicts an example of normalizing item values within a set of items for exchange-specific currencies.

FIG. 39 depicts an example of normalizing item values across sets of items for exchange-specific currencies.

FIG. 40 depicts an example of normalizing a value of an item across a plurality of exchange-specific currencies.

FIG. 41 depicts an example of item value translation among exchanges.

FIG. 42 depicts an example of conditional item value translation among exchanges.

FIG. 43 depicts an example of item-representative token generation for use in a target exchange based on characteristics of the item from a source exchange.

FIG. 44 depicts an example of the item-representative token generation of FIG. 43 through application of item characteristics harvesting algorithms.

FIG. 45 depicts an example of the item-representative token generation of FIG. 43 through processing of smart contracts associated with the item in a source exchange.

FIG. 46 depicts an example of generating a rights token for an item based on at least one of a smart contract and terms and conditions for the item.

FIG. 47 depicts an example of generating a rights token for an item based on at least one of a smart contract and terms and conditions for the item for a range of exchange governing rules.

FIG. 48 depicts an example of generating a rights token for an item based on at least one of a smart contract and terms and conditions for the item and further based on conformance of detected rights with exchange governing rules.

FIG. 49 depicts an example of generating an adaptable rights token for an item based on at least one of a smart contract and terms and conditions for the item and target exchange adaptation rules.

FIG. 50 depicts an example of automatically cascading actions across exchanges in which workflows are automated through robotic process automation.

FIG. 51 depicts an example of automatically cascading workflow initiation actions across exchanges in which the workflows are automated through robotic process automation.

FIG. 52 depicts an example of automatically cascading actions of workflows across exchanges in which the workflows are automated through robotic process automation.

FIG. 53 depicts an example of applying robotic process automation to generate a cross-exchange smart contract from discrete exchange-specific smart contracts.

FIG. 54 depicts an example of a self-adapting asset data delivery network infrastructure pipeline that includes one or more of the normalization, value translation, item tokenization, or rights tokenization methods or systems described herein.

### Intelligent Data Layer FIGS.

FIG. 55 depicts a block diagram of exemplary features, capabilities, and interfaces of an intelligent data layer platform.

FIG. 56 depicts a block diagram of an exemplary intelligent data layer architecture.

FIG. 57 depicts a block diagram of an independently operated intelligent data layer for producing data for a plurality of data consumers.

FIG. 58 depicts a block diagram of an intelligent data layer platform deployment for data-strategic approach of an enterprise.

FIG. 59 depicts a block diagram of a remote intelligent data layer with actively deployed elements for dynamic on-demand IDL operation.

FIG. 60 depicts a diagram of mapping parameters of a data producer (e.g., source) with a data consumer.

FIG. 61 depicts a block diagram of an enterprise deployment of intelligent data layers.

FIG. 62 depicts a block diagram of a network constructed of intelligent data layers.

FIG. 63 depicts a block diagram of an exemplary cloud-based deployment for an intelligent data layer architecture.

FIG. 64 depicts a block diagram of a multi-use (configurable) intelligent data layer architecture to produce different layer content and intelligence for different purposes/uses/consumers.

FIG. 65 depicts a block diagram of a marketplace/transaction environment deployment of intelligent data layers.

FIG. 66 depicts a block diagram of use of intelligent data layers for source discovery.

### Data and Networking Pipeline for Market Orchestration FIGS.

FIGS. 67-84 illustrate various features associated with data network and infrastructure pipelines.

### Cross-Market Transaction Engine FIGS.

FIG. 85 illustrates an exemplary environment of a cross-market transaction engine according to some embodiments of the present disclosure.

FIG. 86 illustrates another exemplary environment of a cross-market transaction engine according to some embodiments of the present disclosure.

### Marketplace Prediction System FIG.

FIG. 87 is a diagrammatic view that illustrates embodiments of the market prediction system platform in accordance with the present disclosure.

### Quantum FIGS.

FIG. 88 is a schematic view of an exemplary embodiment of the quantum computing service according to some embodiments of the present disclosure.

FIG. 89 illustrates quantum computing service request handling according to some embodiments of the present disclosure.

### Trust Network FIGS.

FIG. 90, FIG. 91, FIG. 92, FIG. 93, and FIG. 94 illustrate an example trust network in communication with cryptocurrency transactor computing devices, intermediate transaction systems, and automated transaction systems.

FIG. 95 is a method that describes operation of an example trust network.

FIG. 96 is a functional block diagram of an example node that calculates local trust scores and consensus trust scores.

FIG. 97 is a functional block diagram of an example node that calculates consensus trust scores.

FIG. 98 is a flow diagram that illustrates an example method for calculating a consensus trust score.

FIG. 99 is a functional block diagram of an example node that calculates reputation values.

FIG. 100 is a functional block diagram of an example node that implements a token economy for a trust network.

FIG. 101 illustrates an example method that describes operation of a reward protocol.

FIG. 102 and FIG. 103 illustrate graphical user interfaces (GUIs) for requesting and reviewing trust reports.

FIG. 104 is a functional block diagram of a trust network being used in a payment insurance implementation.

FIG. 105 illustrates an example relationship of staked token and consensus trust score cost.

FIG. 106 illustrates example services associated with different levels of nodes.

FIG. 107 illustrates an example relationship between the number of nodes, the number of cliques, the address overlap, and the probability that a node will get a single address in their control.

FIG. 108 illustrates sample token staking amounts and number of nodes.

FIG. 109 is a functional block diagram of an example trust score determination module and local trust data store.

FIG. 110 is a method that describes operation of an example trust score determination module.

FIG. 111 is a functional block diagram of a data acquisition and processing module.

FIG. 112 is a functional block diagram of a blockchain data acquisition and processing module.

FIG. 113 and FIG. 114 illustrate generation and processing of a blockchain graph data structure.

FIG. 115 is a functional block diagram of a scoring feature generation module and a scoring model generation module.

FIG. 116 is a functional block diagram that illustrates operation of a score generation module.

FIG. 117 illustrates an environment that includes a cryptocurrency blockchain network that executes smart contracts.

FIG. 118 illustrates a method that describes operation of the environment of FIG. 117.

FIG. 119 is a functional block diagram that illustrates interactions between a sender user device, an intermediate transaction system, a blockchain network, and a trust network/system.

FIG. 120 and FIG. 121 illustrate an example trust system and an example trust node that can determine trust scores for blockchain addresses.

FIG. 122 and FIG. 123 illustrate an example sender interface on a user device.

FIG. 124 illustrates an example method describing operation of an intermediate transaction system.

FIG. 125 illustrates an example method describing operation of a trust network/system.

### Dual Process Artificial Neural Network Figures

FIG. 126 is a diagrammatic view of a dual process artificial neural network system in accordance with some embodiments.

FIG. 127 is a diagrammatic view that illustrates embodiments of the biology-based system in accordance with the present disclosure.

FIG. 128 is a diagrammatic view of a thalamus service in accordance with the present disclosure.

### Process Automation and Artificial Intelligence Figures

FIG. 129 provides an exemplary block diagram illustration of a transaction environment (e.g., a marketplace or a set of marketplaces), in accordance with example embodiments of the disclosure.

FIG. 130 provides an exemplary block diagram illustration of a system implementing a processing system for automation of transactions in the marketplace, in accordance with example embodiments of the disclosure.

FIG. 131 provides an exemplary block diagram illustration of the processing system of FIG. 130 showing various modules therein, in accordance with example embodiments of the disclosure.

FIG. 132 provides an exemplary flowchart for automation of transactions in the marketplace, in accordance with example embodiments of the disclosure.

FIG. 133 provides an exemplary block diagram illustration of a system implementing a processing system for managing transactions in the marketplace, in accordance with example embodiments of the disclosure.

FIG. 134 provides an exemplary block diagram illustration of the processing system of FIG. 133 showing various modules therein, in accordance with example embodiments of the disclosure.

FIG. 135 provides an exemplary flowchart for automation of transactions in the marketplace, in accordance with example embodiments of the disclosure.

FIG. 136 provides an exemplary block diagram illustration of a system implementing a processing system for automating processing of transactions in the marketplace, in accordance with example embodiments of the disclosure.

FIG. 137 provides an exemplary block diagram illustration of the processing system of FIG. 136 showing various modules therein, in accordance with example embodiments of the disclosure.

FIG. 138 provides an exemplary flowchart for automating processing of transactions in the marketplace, in accordance with example embodiments of the disclosure.

FIG. 139 provides an exemplary block diagram illustration of a system for automated orchestration of the marketplace, in accordance with example embodiments of the disclosure.

FIG. 140 provides an exemplary flowchart for automated orchestration of the marketplace, in accordance with example embodiments of the disclosure.

FIG. 141 provides an exemplary block diagram illustration of a system for augmenting of services in the marketplace, in accordance with example embodiments of the disclosure.

FIG. 142 provides an exemplary flowchart for augmenting of services in the marketplace, in accordance with example embodiments of the disclosure.

### DETAILED DESCRIPTION

The term services/microservices (and similar terms) as utilized herein should be understood broadly. Without limitation to any other aspect or description of the present disclosure, a service/microservice includes any system (or platform) configured to functionally perform the operations of the service, where the system may be data-integrated, including data collection circuits, blockchain circuits, artificial intelligence circuits, and/or smart contract circuits for handling lending entities and transactions. Services/microservices may facilitate data handling and may include facilities for data extraction, transformation and loading; data cleansing and deduplication facilities; data normalization facilities; data synchronization facilities; data security facilities; computational facilities (e.g., for performing pre-defined calculation operations on data streams and providing an output stream); compression and de-compression facilities; analytic facilities (such as providing automated production of data visualizations), data processing facilities, and/or data storage facilities (including storage retention, formatting, compression, migration, etc.), and others.

Services/microservices may include controllers, processors, network infrastructure, input/output devices, servers, client devices (e.g., laptops, desktops, terminals, mobile devices, and/or dedicated devices), sensors (e.g., IoT sensors associated with one or more entities, equipment, and/or collateral), actuators (e.g., automated locks, notification devices, lights, camera controls, etc.), virtualized versions of any one or more of the foregoing (e.g., outsourced computing resources such as a cloud storage, computing operations; virtual sensors; subscribed data to be gathered such as stock or commodity prices, recordal logs, etc.), and/or include components configured as computer readable instructions that, when performed by a processor, cause the processor to perform one or more functions of the service, etc. Services may be distributed across a number of devices, and/or functions of a service may be performed by one or more devices cooperating to perform the given function of the service.

Services/microservices may include application programming interfaces that facilitate connection among the components of the system performing the service (e.g., microservices) and between the system to entities (e.g., programs, websites, user devices, etc.) that are external to the system. Without limitation to any other aspect of the present disclosure, example microservices that may be present in certain embodiments include (a) a multi-modal set of data collection circuits that collect information about and monitor entities related to a lending transaction; (b) blockchain circuits for maintaining a secure historical ledger of events related to a loan, the blockchain circuits having access control features that govern access by a set of parties involved in a loan; (c) a set of application programming interfaces, data integration services, data processing workflows and user interfaces for handling loan-related events and loan-related activities; and (d) smart contract circuits for specifying terms and conditions of smart contracts that govern at least one of loan terms and conditions, loan-related events, and loan-related activities. Any of the services/microservices may be controlled by or have control over a controller. Certain systems may not be considered to be a service/microservice. For example, a point of sale device that simply charges a set cost for a good or service may not be a service. In another example, a service that tracks the cost of a good or service and triggers notifications when the value changes may not be a valuation service itself, but may rely on valuation services, and/or may form a portion of a valuation service in certain embodiments. It can be seen that a given circuit, controller, or device may be a service or a part of a service in certain embodiments, such as when the functions or capabilities of the circuit, controller, or device are configured to support a service or microservice as described herein, but may not be a service or part of a service for other embodiments (e.g., where the functions or capabilities of the circuit, controller, or device are not relevant to a service or microservice as described herein). In another example, a mobile device being operated by a user may form a portion of a service as described herein at a first point in time (e.g., when the user accesses a feature of the service through an application or other communication from the mobile device, and/or when a monitoring function is being performed via the mobile device), but may not form a portion of the service at a second point in time (e.g., after a transaction is completed, after the user un-installs an application, and/or when a monitoring function is stopped and/or passed to another device). Accordingly, the benefits of the present disclosure may be applied in a wide variety of processes or systems, and any such processes or systems may be considered a service (or a part of a service) herein.

One of skill in the art, having the benefit of the disclosure herein and knowledge about a contemplated system ordinarily available to that person, can readily determine which aspects of the present disclosure will benefit a particular system, how to combine processes and systems from the present disclosure to construct, provide performance characteristics (e.g., bandwidth, computing power, time response, etc.), and/or provide operational capabilities (e.g., time between checks, up-time requirements including longitudinal (e.g., continuous operating time) and/or sequential (e.g., time-of-day, calendar time, etc.), resolution and/or accuracy of sensing, data determinations (e.g., accuracy, timing, amount of data), and/or actuator confirmation capability) of components of the service that are sufficient to provide a given embodiment of a service, platform, and/or microservice as described herein. Certain considerations for the person of skill in the art, in determining the configuration of components, circuits, controllers, and/or devices to implement a service, platform, and/or microservice (“service” in the listing following) as described herein include, without limitation: the balance of capital costs versus operating costs in implementing and operating the service; the availability, speed, and/or bandwidth of network services available for system components, service users, and/or other entities that interact with the service; the response time of considerations for the service (e.g., how quickly decisions within the service must be implemented to support the commercial function of the service, the operating time for various artificial intelligence or other high computation operations) and/or the capital or operating cost to support a given response time; the location of interacting components of the service, and the effects of such locations on operations of the service (e.g., data storage locations and relevant regulatory schemes, network communication limitations and/or costs, power costs as a function of the location, support availability for time zones relevant to the service, etc.); the availability of certain sensor types, the related support for those sensors, and the availability of sufficient substitutes (e.g., a camera may require supportive lighting, and/or high network bandwidth or local storage) for the sensing purpose; an aspect of the underlying value of an aspect of the service (e.g., a principal amount of a loan, a value of collateral, a volatility of the collateral value, a net worth or relative net worth of a lender, guarantor, and/or borrower, etc.) including the time sensitivity of the underlying value (e.g., if it changes quickly or slowly relative to the operations of the service or the term of the loan); a trust indicator between parties of a transaction (e.g., history of performance between the parties, a credit rating, social rating, or other external indicator, conformance of activity related to the transaction to an industry standard or other normalized transaction type, etc.); and/or the availability of cost recovery options (e.g., subscriptions, fees, payment for services, etc.) for given configurations and/or capabilities of the service, platform, and/or microservice. Without limitation to any other aspect of the present disclosure, certain operations performed by services herein include: performing real-time alterations to a loan based on tracked data; utilizing data to execute a collateral-backed smart contract; re-evaluating debt transactions in response to a tracked condition or data, and the like. While specific examples of services/microservices and considerations are described herein for purposes of illustration, any system benefitting from the disclosures herein, and any considerations understood to one of skill in the art having the benefit of the disclosures herein, are specifically contemplated within the scope of the present disclosure.

Without limitation, services include a financial service (e.g., a loan transaction service), a data collection service (e.g., a data collection service for collecting and monitoring data), a blockchain service (e.g., a blockchain service to maintain secure data), data integration services (e.g., a data integration service to aggregate data), smart contract services (e.g., a smart contract service to determine aspects of smart contracts), software services (e.g., a software service to extract data related to the entities from publicly available information sites), crowdsourcing services (e.g., a crowdsourcing service to solicit and report information), Internet of Things services (e.g., an Internet of Things service to monitor an environment), publishing services (e.g., a publishing services to publish data), microservices (e.g., having a set of application programming interfaces that facilitate connection among the microservices), valuation services (e.g., that use a valuation model to set a value for collateral based on information), artificial intelligence services, market value data collection services (e.g., that monitor and report on marketplace information), clustering services (e.g., for grouping the collateral items based on similarity of attributes), social networking services (e.g., that enables configuration with respect to parameters of a social network), asset identification services (e.g., for identifying a set of assets for which a financial institution is responsible for taking custody), identity management services (e.g., by which a financial institution verifies identities and credentials), and the like, and/or similar functional terminology. Example services to perform one or more functions herein include computing devices; servers; networked devices; user interfaces; inter-device interfaces such as communication protocols, shared information and/or information storage, and/or application programming interfaces (APIs); sensors (e.g., IoT sensors operationally coupled to monitored components, equipment, locations, or the like); distributed ledgers; circuits; and/or computer readable code configured to cause a processor to execute one or more functions of the service. One or more aspects or components of services herein may be distributed across a number of devices, and/or may be consolidated, in whole or part, on a given device. In embodiments, aspects or components of services herein may be implemented at least in part through circuits, such as, in non-limiting examples, a data collection service implemented at least in part as a data collection circuit structured to collect and monitor data, a blockchain service implemented at least in part as a blockchain circuit structured to maintain secure data, data integration services implemented at least in part as a data integration circuit structured to aggregate data, smart contract services implemented at least in part as a smart contract circuit structured to determine aspects of smart contracts, software services implemented at least in part as a software service circuit structured to extract data related to the entities from publicly available information sites, crowdsourcing services implemented at least in part as a crowdsourcing circuit structured to solicit and report information, Internet of Things services implemented at least in part as an Internet of Things circuit structured to monitor an environment, publishing services implemented at least in part as a publishing services circuit structured to publish data, microservice service implemented at least in part as a microservice circuit structured to interconnect a plurality of service circuits, valuation service implemented at least in part as valuation services circuit structured to access a valuation model to set a value for collateral based on data, artificial intelligence service implemented at least in part as an artificial intelligence services circuit, market value data collection service implemented at least in part as market value data collection service circuit structured to monitor and report on marketplace information, clustering service implemented at least in part as a clustering services circuit structured to group collateral items based on similarity of attributes, a social networking service implemented at least in part as a social networking analytic services circuit structured to configure parameters with respect to a social network, asset identification services implemented at least in part as an asset identification service circuit for identifying a set of assets for which a financial institution is responsible for taking custody, identity management services implemented at least in part as an identity management service circuit enabling a financial institution to verify identities and credentials, and the like. Accordingly, the benefits of the present disclosure may be applied in a wide variety of systems, and any such systems may be considered with respect to items and services herein, while in certain embodiments a given system may not be considered with respect to items and services herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Among the considerations that one of skill in the art may contemplate to determine a configuration for a particular service include: the distribution and access devices available to one or more parties to a particular transaction; jurisdictional limitations on the storage, type, and communication of certain types of information; requirements or desired aspects of security and verification of information communication for the service; the response time of information gathering, inter-party communications, and determinations to be made by algorithms, machine learning components, and/or artificial intelligence components of the service; cost considerations of the service, including capital expenses and operating costs, as well as which party or entity will bear the costs and availability to recover costs such as through subscriptions, service fees, or the like; the amount of information to be stored and/or communicated to support the service; and/or the processing or computing power to be utilized to support the service.

The terms items and services (and similar terms) as utilized herein should be understood broadly. Without limitation to any other aspect or description of the present disclosure, items and service include any items and service, including, without limitation, items and services used as a reward, used as collateral, become the subject of a negotiation, and the like, such as, without limitation, an application for a warranty or guarantee with respect to an item that is the subject of a loan, collateral for a loan, or the like, such as a product, a service, an offering, a solution, a physical product, software, a level of service, quality of service, a financial instrument, a debt, an item of collateral, performance of a service, or other items. Without limitation to any other aspect or description of the present disclosure, items and service include any items and service, including, without limitation, items and services as applied to physical items (e.g., a vehicle, a ship, a plane, a building, a home, real estate property, undeveloped land, a farm, a crop, a municipal facility, a warehouse, a set of inventory, an antique, a fixture, an item of furniture, an item of equipment, a tool, an item of machinery, and an item of personal property), a financial item (e.g., a commodity, a security, a currency, a token of value, a ticket, a cryptocurrency), a consumable item (e.g., an edible item, a beverage), a highly valued item (e.g., a precious metal, an item of jewelry, a gemstone), an intellectual item (e.g., an item of intellectual property, an intellectual property right, a contractual right), and the like. Accordingly, the benefits of the present disclosure may be applied in a wide variety of systems, and any such systems may be considered with respect to items and services herein, while in certain embodiments a given system may not be considered with respect to items and services herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system.

The terms agent, automated agent, and similar terms as utilized herein should be understood broadly. Without limitation to any other aspect or description of the present disclosure, an agent or automated agent may process events relevant to at least one of the value, the condition, and the ownership of items of collateral or assets. The agent or automated agent may also undertake an action related to a loan, debt transaction, bond transaction, subsidized loan, or the like to which the collateral or asset is subject, such as in response to the processed events. The agent or automated agent may interact with a marketplace for purposes of collecting data, testing spot market transactions, executing transactions, and the like, where dynamic system behavior involves complex interactions that a user may desire to understand, predict, control, and/or optimize. Certain systems may not be considered an agent or an automated agent. For example, if events are merely collected but not processed, the system may not be an agent or automated agent. In some embodiments, if a loan-related action is undertaken not in response to a processed event, it may not have been undertaken by an agent or automated agent. One of skill in the art, having the benefit of the disclosure herein and knowledge about a contemplated system ordinarily available to that person, can readily determine which aspects of the present disclosure include and/or benefit from agents or automated agent. Certain considerations for the person of skill in the art, or embodiments of the present disclosure with respect to an agent or automated agent include, without limitation: rules that determine when there is a change in a value, condition or ownership of an asset or collateral, and/or rules to determine if a change warrants a further action on a loan or other transaction, and other considerations. While specific examples of market values and marketplace information are described herein for purposes of illustration, any embodiment benefitting from the disclosures herein, and any considerations understood to one of skill in the art having the benefit of the disclosures herein are specifically contemplated within the scope of the present disclosure.

The term marketplace information, market value and similar terms as utilized herein should be understood broadly. Without limitation to any other aspect or description of the present disclosure, marketplace information and market value describe a status or value of an asset, collateral, food, or service at a defined point or period in time. Market value may refer to the expected value placed on an item in a marketplace or auction setting, or pricing or financial data for items that are similar to the item, asset, or collateral in at least one public marketplace. For a company, market value may be the number of its outstanding shares multiplied by the current share price. Valuation services may include market value data collection services that monitor and report on marketplace information relevant to the value (e.g., market value) of collateral, the issuer, a set of bonds, and a set of assets. a set of subsidized loans, a party, and the like. Market values may be dynamic in nature because they depend on an assortment of factors, from physical operating conditions to economic climate to the dynamics of demand and supply. Market value may be affected by, and marketplace information may include, proximity to other assets, inventory or supply of assets, demand for assets, origin of items, history of items, underlying current value of item components, a bankruptcy condition of an entity, a foreclosure status of an entity, a contractual default status of an entity, a regulatory violation status of an entity, a criminal status of an entity, an export controls status of an entity, an embargo status of an entity, a tariff status of an entity, a tax status of an entity, a credit report of an entity, a credit rating of an entity, a website rating of an entity, a set of customer reviews for a product of an entity, a social network rating of an entity, a set of credentials of an entity, a set of referrals of an entity, a set of testimonials for an entity, a set of behavior of an entity, a location of an entity, and a geolocation of an entity. In certain embodiments, a market value may include information such as a volatility of a value, a sensitivity of a value (e.g., relative to other parameters having an uncertainty associated therewith), and/or a specific value of the valuated object to a particular party (e.g., an object may have more value as possessed by a first party than as possessed by a second party).

Certain information may not be marketplace information or a market value. For example, where variables related to a value are not market-derived, they may be a value-in-use or an investment value. In certain embodiments, an investment value may be considered a market value (e.g., when the valuating party intends to utilize the asset as an investment if acquired), and not a market value in other embodiments (e.g., when the valuating party intends to immediately liquidate the investment if acquired). One of skill in the art, having the benefit of the disclosure herein and knowledge about a contemplated system ordinarily available to that person, can readily determine which aspects of the present disclosure will benefit from marketplace information or a market value. Certain considerations for the person of skill in the art, in determining whether the term market value is referring to an asset, item, collateral, good, or service include: the presence of other similar assets in a marketplace, the change in value depending on location, an opening bid of an item exceeding a list price, and other considerations. While specific examples of market values and marketplace information are described herein for purposes of illustration, any embodiment benefitting from the disclosures herein, and any considerations understood to one of skill in the art having the benefit of the disclosures herein are specifically contemplated within the scope of the present disclosure.

The term apportion value or apportioned value and similar terms as utilized herein should be understood broadly. Without limitation to any other aspect or description of the present disclosure, apportion value describes a proportional distribution or allocation of value proportionally, or a process to divide and assign value according to a rule of proportional distribution. Apportionment of the value may be to several parties (e.g., each of the several parties is a beneficiary of a portion of the value), to several transactions (e.g., each of the transactions utilizes a portion of the value), and/or in a many-to-many relationship (e.g., a group of objects has an aggregate value that is apportioned between a number of parties and/or transactions). In some embodiments, the value may be a net loss and the apportioned value is the allocation of a liability to each entity. In other embodiments, apportioned value may refer to the distribution or allocation of an economic benefit, real estate, collateral, or the like. In certain embodiments, apportionment may include a consideration of the value relative to the parties, for example, a $10 million asset apportioned 50/50 between two parties, where the parties have distinct value considerations for the asset, may result in one party crediting the apportionment differing resulting values from the apportionment. In certain embodiments, apportionment may include a consideration of the value relative to given transactions, for example, a first type of transaction (e.g., a long-term loan) may have a different valuation of a given asset than a second type of transaction (e.g., a short-term line of credit).

Certain conditions or processes may not relate to apportioned value. For example, the total value of an item may provide its inherent worth, but not how much of the value is held by each identified entity. One of skill in the art, having the benefit of the disclosure herein and knowledge about apportioned value, can readily determine which aspects of the present disclosure will benefit a particular application for apportioned value. Certain considerations for the person of skill in the art, or embodiments of the present disclosure with respect to an apportioned value include, without limitation: the currency of the principal sum, the anticipated transaction type (loan, bond or debt), the specific type of collateral, the ratio of the loan to value, the ratio of the collateral to the loan, the gross transaction/loan amount, the amount of the principal sum, the number of entities owed, the value of the collateral, and the like. While specific examples of apportioned values are described herein for purposes of illustration, any embodiment benefitting from the disclosures herein, and any considerations understood to one of skill in the art having the benefit of the disclosures herein are specifically contemplated within the scope of the present disclosure.

The term financial condition and similar terms as utilized herein should be understood broadly. Without limitation to any other aspect or description of the present disclosure, financial condition describes a current status of an entity's assets, liabilities, and equity positions at a defined point or period in time. The financial condition may be memorialized in financial statement. The financial condition may further include an assessment of the ability of the entity to survive future risk scenarios or meet future or maturing obligations. Financial condition may be based on a set of attributes of the entity selected from among a publicly stated valuation of the entity, a set of property owned by the entity as indicated by public records, a valuation of a set of property owned by the entity, a bankruptcy condition of an entity, a foreclosure status of an entity, a contractual default status of an entity, a regulatory violation status of an entity, a criminal status of an entity, an export controls status of an entity, an embargo status of an entity, a tariff status of an entity, a tax status of an entity, a credit report of an entity, a credit rating of an entity, a website rating of an entity, a set of customer reviews for a product of an entity, a social network rating of an entity, a set of credentials of an entity, a set of referrals of an entity, a set of testimonials for an entity, a set of behavior of an entity, a location of an entity, and a geolocation of an entity. A financial condition may also describe a requirement or threshold for an agreement or loan. For example, conditions for allowing a developer to proceed may be various certifications and their agreement to a financial payout. That is, the developer's ability to proceed is conditioned upon a financial element, among others. Certain conditions may not be a financial condition. For example, a credit card balance alone may be a clue as to the financial condition, but may not be the financial condition on its own. In another example, a payment schedule may determine how long a debt may be on an entity's balance sheet, but in a silo may not accurately provide a financial condition. One of skill in the art, having the benefit of the disclosure herein and knowledge about a contemplated system ordinarily available to that person, can readily determine which aspects of the present disclosure include and/or will benefit from a financial condition. Certain considerations for the person of skill in the art, in determining whether the term financial condition is referring to a current status of an entity's assets, liabilities, and equity positions at a defined point or period in time and/or for a given purpose include: the reporting of more than one financial data point, the ratio of a loan to value of collateral, the ratio of the collateral to the loan, the gross transaction/loan amount, the credit scores of the borrower and the lender, and other considerations. While specific examples of financial conditions are described herein for purposes of illustration, any embodiment benefitting from the disclosures herein, and any considerations understood to one of skill in the art having the benefit of the disclosures herein are specifically contemplated within the scope of the present disclosure.

The term interest rate and similar terms, as utilized herein should be understood broadly. Without limitation to any other aspect or description of the present disclosure, interest rate includes an amount of interest due per period, as a proportion of an amount lent, deposited, or borrowed. The total interest on an amount lent or borrowed may depend on the principal sum, the interest rate, the compounding frequency, and the length of time over which it is lent, deposited, or borrowed. Typically, interest rate is expressed as an annual percentage but can be defined for any time period. The interest rate relates to the amount a bank or other lender charges to borrow its money, or the rate a bank or other entity pays its savers for keeping money in an account. Interest rate may be variable or fixed. For example, an interest rate may vary in accordance with a government or other stakeholder directive, the currency of the principal sum lent or borrowed, the term to maturity of the investment, the perceived default probability of the borrower, supply and demand in the market, the amount of collateral, the status of an economy, or special features like call provisions. In certain embodiments, an interest rate may be a relative rate (e.g., relative to a prime rate, an inflation index, etc.). In certain embodiments, an interest rate may further consider costs or fees applied (e.g., “points”) to adjust the interest rate. A nominal interest rate may not be adjusted for inflation while a real interest rate takes inflation into account. Certain examples may not be an interest rate for purposes of particular embodiments. For example, a bank account growing by a fixed dollar amount each year, and/or a fixed fee amount, may not be an example of an interest rate for certain embodiments. One of skill in the art, having the benefit of the disclosure herein and knowledge about interest rates, can readily determine the characteristics of an interest rate for a particular embodiment. Certain considerations for the person of skill in the art, or embodiments of the present disclosure with respect to an interest rate include, without limitation: the currency of the principal sum, variables for setting an interest rate, criteria for modifying an interest rate, the anticipated transaction type (loan, bond or debt), the specific type of collateral, the ratio of the loan to value, the ratio of the collateral to the loan, the gross transaction/loan amount, the amount of the principal sum, the appropriate lifespans of transactions and/or collateral for a particular industry, the likelihood that a lender will sell and/or consolidate a loan before the term, and the like. While specific examples of interest rates are described herein for purposes of illustration, any embodiment benefitting from the disclosures herein, and any considerations understood to one of skill in the art having the benefit of the disclosures herein are specifically contemplated within the scope of the present disclosure.

The term valuation services (and similar terms) as utilized herein should be understood broadly. Without limitation to any other aspect or description of the present disclosure, a valuation service includes any service that sets a value for a good or service. Valuation services may use a valuation model to set a value for collateral based on information from data collection and monitoring services. Smart contract services may process output from the set of valuation services and assign items of collateral sufficient to provide security for a loan and/or apportion value for an item of collateral among a set of lenders and/or transactions. Valuation services may include artificial intelligence services that may iteratively improve the valuation model based on outcome data relating to transactions in collateral. Valuation services may include market value data collection services that may monitor and report on marketplace information relevant to the value of collateral. Certain processes may not be considered to be a valuation service. For example, a point of sale device that simply charges a set cost for a good or service may not be a valuation service. In another example, a service that tracks the cost of a good or service and triggers notifications when the value changes may not be a valuation service itself, but may rely on valuation services and/or form a part of a valuation service. Accordingly, the benefits of the present disclosure may be applied in a wide variety of processes systems, and any such processes or systems may be considered a valuation service herein, while in certain embodiments a given service may not be considered a valuation service herein. One of skill in the art, having the benefit of the disclosure herein and knowledge about a contemplated system ordinarily available to that person, can readily determine which aspects of the present disclosure will benefit a particular system and how to combine processes and systems from the present disclosure to enhance operations of the contemplated system and/or to provide a valuation service. Certain considerations for the person of skill in the art, in determining whether a contemplated system is a valuation service and/or whether aspects of the present disclosure can benefit or enhance the contemplated system include, without limitation: perform real-time alterations to a loan based on a value of a collateral; utilize marketplace data to execute a collateral-backed smart contract; re-evaluate collateral based on a storage condition or geolocation; the tendency of the collateral to have a volatile value, be utilized, and/or be moved; and the like. While specific examples of valuation services and considerations are described herein for purposes of illustration, any system benefitting from the disclosures herein, and any considerations understood to one of skill in the art having the benefit of the disclosures herein, are specifically contemplated within the scope of the present disclosure.

The term collateral attributes (and similar terms) as utilized herein should be understood broadly. Without limitation to any other aspect or description of the present disclosure, collateral attributes include any identification of the durability (ability of the collateral to withstand wear or the useful life of the collateral), value, identification (does the collateral have definite characteristics that make it easy to identify or market), stability of value (does the collateral maintain value over time), standardization, grade, quality, marketability, liquidity, transferability, desirability, trackability, deliverability (ability of the collateral be delivered or transfer without a deterioration in value), market transparency (is the collateral value easily verifiable or widely agreed upon), physical or virtual. Collateral attributes may be measured in absolute or relative terms, and/or may include qualitative (e.g., categorical descriptions) or quantitative descriptions. Collateral attributes may be different for different industries, products, elements, uses, and the like. Collateral attributes may be assigned quantitative or qualitative values. Values associated with collateral attributes may be based on a scale (such as 1-10) or a relative designation (high, low, better, etc.). Collateral may include various components; each component may have collateral attributes. Collateral may, therefore, have multiple values for the same collateral attribute. In some embodiments, multiple values of collateral attributes may be combined to generate one value for each attribute. Some collateral attributes may apply only to specific portions of collateral. Some collateral attributes, even for a given component of the collateral, may have distinct values depending upon the party of interest (e.g., a party that values an aspect of the collateral more highly than another party) and/or depending upon the type of transaction (e.g., the collateral may be more valuable or appropriate for a first type of loan than for a second type of loan). Certain attributes associated with collateral may not be collateral attributes as described herein depending upon the purpose of the collateral attributes herein. For example, a product may be rated as durable relative to similar products; however, if the life of the product is much lower than the term of a particular loan in consideration, the durability of the product may be rated differently (e.g., not durable) or irrelevant (e.g., where the current inventory of the product is attached as the collateral, and is expected to change out during the term of the loan). Accordingly, the benefits of the present disclosure may be applied to a variety of attributes, and any such attributes may be considered collateral attributes herein, while in certain embodiments a given attribute may not be considered a collateral attribute herein. One of skill in the art, having the benefit of the disclosure herein and knowledge about contemplated collateral attributes ordinarily available to that person, can readily determine which aspects of the present disclosure will benefit a particular collateral attribute. Certain considerations for the person of skill in the art, in determining whether a contemplated attribute is a collateral attribute and/or whether aspects of the present disclosure can benefit or enhance the contemplated system include, without limitation: the source of the attribute and the source of the value of the attribute (e.g., does the attribute and attribute value comes from a reputable source), the volatility of the attribute (e.g., does the attribute values for the collateral fluctuate, is the attribute a new attribute for the collateral), relative differences in attribute values for similar collateral, exceptional values for attributes (e.g., some attribute values may be high, such as, in the 98th percentile or very low, such as in the 2nd percentile, compared to similar class of collateral), the fungibility of the collateral, the type of transaction related to the collateral, and/or the purpose of the utilization of collateral for a particular party or transaction. While specific examples of collateral attributes and considerations are described herein for purposes of illustration, any system benefitting from the disclosures herein, and any considerations understood to one of skill in the art having the benefit of the disclosures herein, are specifically contemplated within the scope of the present disclosure.

The term blockchain services (and similar terms) as utilized herein should be understood broadly. Without limitation to any other aspect or description of the present disclosure, blockchain services include any service related to the processing, recordation, and/or updating of a blockchain, and may include services for processing blocks, computing hash values, generating new blocks in a blockchain, appending a block to the blockchain, creating a fork in the blockchain, merging of forks in the blockchain, verifying previous computations, updating a shared ledger, updating a distributed ledger, generating cryptographic keys, verifying transactions, maintaining a blockchain, updating a blockchain, verifying a blockchain, generating random numbers. The services may be performed by execution of computer readable instructions on local computers and/or by remote servers and computers. Certain services may not be considered blockchain services individually but may be considered blockchain services based on the final use of the service and/or in a particular embodiment, for example, a computing a hash value may be performed in a context outside of a blockchain such in the context of secure communication. Some initial services may be invoked without first being applied to blockchains, but further actions or services in conjunction with the initial services may associate the initial service with aspects of blockchains. For example, a random number may be periodically generated and stored in memory; the random numbers may initially not be generated for blockchain purposes but may be utilized for blockchains. Accordingly, the benefits of the present disclosure may be applied in a wide variety of services, and any such services may be considered blockchain services herein, while in certain embodiments a given service may not be considered a blockchain service herein. One of skill in the art, having the benefit of the disclosure herein and knowledge about a contemplated blockchain service ordinarily available to that person, can readily determine which aspects of the present disclosure can be configured to implement, and/or will benefit, a particular blockchain service. Certain considerations for the person of skill in the art, in determining whether a contemplated service is a blockchain service and/or whether aspects of the present disclosure can benefit or enhance the contemplated system include, without limitation: the application of the service, the source of the service (e.g., if the service is associated with a known or verifiable blockchain service provider), responsiveness of the service (e.g., some blockchain services may have an expected completion time, and/or may be determined through utilization), cost of the service, the amount of data requested for the service, and/or the amount of data generated by the service (blocks of blockchain or keys associated with blockchains may be a specific size or a specific range of sizes). While specific examples of blockchain services and considerations are described herein for purposes of illustration, any system benefitting from the disclosures herein, and any considerations understood to one of skill in the art having the benefit of the disclosures herein, are specifically contemplated within the scope of the present disclosure.

The term blockchain (and variations such as cryptocurrency ledger, and the like) as utilized herein may be understood broadly to describe a cryptocurrency ledger that records, administrates, or otherwise processes online transactions. A blockchain may be public, private, or a combination thereof, without limitation. A blockchain may also be used to represent a set of digital transactions, agreement, terms, or other digital value. Without limitation to any other aspect or description of the present disclosure, in the former case, a blockchain may also be used in conjunction with investment applications, token-trading applications, and/or digital/cryptocurrency based marketplaces. A blockchain can also be associated with rendering consideration, such as providing goods, services, items, fees, access to a restricted area or event, data, or other valuable benefit. Blockchains in various forms may be included where discussing a unit of consideration, collateral, currency, cryptocurrency, or any other form of value. One of skill in the art, having the benefit of the disclosure herein and knowledge ordinarily available about a contemplated system, can readily determine the value symbolized or represented by a blockchain. While specific examples of blockchains are described herein for purposes of illustration, any embodiment benefitting from the disclosures herein, and any considerations understood to one of skill in the art having the benefit of the disclosures herein, are specifically contemplated within the scope of the present disclosure.

The terms ledger and distributed ledger (and similar terms) as utilized herein should be understood broadly. Without limitation to any other aspect or description of the present disclosure, a ledger may be a document, file, computer file, database, book, and the like which maintains a record of transactions. Ledgers may be physical or digital. Ledgers may include records related to sales, accounts, purchases, transactions, assets, liabilities, incomes, expenses, capital, and the like. Ledgers may provide a history of transactions that may be associated with time. Ledgers may be centralized or decentralized/distributed. A centralized ledger may be a document that is controlled, updated, or viewable by one or more selected entities or a clearinghouse and wherein changes or updates to the ledger are governed or controlled by the entity or clearinghouse. A distributed ledger may be a ledger that is distributed across a plurality of entities, participants or regions which may independently, concurrently, or consensually, update, or modify their copies of the ledger. Ledgers and distributed ledgers may include security measures and cryptographic functions for signing, concealing, or verifying content. In the case of distributed ledgers, blockchain technology may be used. In the case of distributed ledgers implemented using blockchain, the ledger may be Merkle trees comprising a linked list of nodes in which each node contains hashed or encrypted transactional data of the previous nodes. Certain records of transactions may not be considered ledgers. A file, computer file, database, or book may or may not be a ledger depending on what data it stores, how the data is organized, maintained, or secured. For example, a list of transactions may not be considered a ledger if it cannot be trusted or verified, and/or if it is based on inconsistent, fraudulent, or incomplete data. Data in ledgers may be organized in any format such as tables, lists, binary streams of data, or the like which may depend on convenience, source of data, type of data, environment, applications, and the like. A ledger that is shared among various entities may not be a distributed ledger, but the distinction of distributed may be based on which entities are authorized to make changes to the ledger and/or how the changes are shared and processed among the different entities. Accordingly, the benefits of the present disclosure may be applied in a wide variety of data, and any such data may be considered ledgers herein, while in certain embodiments a given data may not be considered a ledger herein. One of skill in the art, having the benefit of the disclosure herein and knowledge about contemplated ledgers and distributed ledger ordinarily available to that person, can readily determine which aspects of the present disclosure can be utilized to implement, and/or will benefit a particular ledger. Certain considerations for the person of skill in the art, in determining whether a contemplated data is a ledger and/or whether aspects of the present disclosure can benefit or enhance the contemplated ledger include, without limitation: the security of the data in the ledger (can the data be tampered or modified), the time associated with making changes to the data in the ledger, cost of making changes (computationally and monetarily), detail of data, organization of data (does the data need to be processed for use in an application), who controls the ledger (can the party be trusted or relied to manage the ledger), confidentiality of the data (who can see or track the data in the ledger), size of the infrastructure, communication requirements (distributed ledgers may require a communication interface or specific infrastructure), resiliency. While specific examples of blockchain services and considerations are described herein for purposes of illustration, any system benefitting from the disclosures herein, and any considerations understood to one of skill in the art having the benefit of the disclosures herein, are specifically contemplated within the scope of the present disclosure.

The term loan (and similar terms) as utilized herein should be understood broadly. Without limitation to any other aspect or description of the present disclosure, a loan may be an agreement related to an asset that is borrowed, and that is expected to be returned in kind (e.g., money borrowed, and money returned) or as an agreed transaction (e.g., a first good or service is borrowed, and money, a second good or service, or a combination, is returned). Assets may be money, property, time, physical objects, virtual objects, services, a right (e.g., a ticket, a license, or other rights), a depreciation amount, a credit (e.g., a tax credit, an emissions credit, etc.), an agreed assumption of a risk or liability, and/or any combination thereof. A loan may be based on a formal or informal agreement between a borrower and a lender wherein a lender may provide an asset to the borrower for a predefined amount of time, a variable period of time, or indefinitely. Lenders and borrowers may be individuals, entities, corporations, governments, groups of people, organizations, and the like. Loan types may include mortgage loans, personal loans, secured loans, unsecured loans, concessional loans, commercial loans, microloans, and the like. The agreement between the borrower and the lender may specify terms of the loan. The borrower may be required to return an asset or repay with a different asset than was borrowed. In some cases, a loan may require interest to be repaid on the borrowed asset. Borrowers and lenders may be intermediaries between other entities and may never possess or use the asset. In some embodiments, a loan may not be associated with direct transfer of goods but may be associated with usage rights or shared usage rights. In certain embodiments, the agreement between the borrower and the lender may be executed between the borrower and the lender, and/or executed between an intermediary (e.g., a beneficiary of a loan right such as through a sale of the loan). In certain embodiments, the agreement between the borrower and the lender may be executed through services herein, such as through a smart contract service that determines at least a portion of the terms and conditions of the loans, and in certain embodiments may commit the borrower and/or the lender to the terms of the agreement, which may be a smart contract. In certain embodiments, the smart contract service may populate the terms of the agreement, and present them to the borrower and/or lender for execution. In certain embodiments, the smart contract service may automatically commit one of the borrower or the lender to the terms (at least as an offer) and may present the offer to the other one of the borrower or the lender for execution. In certain embodiments, a loan agreement may include multiple borrowers and/or multiple lenders, for example where a set of loans includes a number of beneficiaries of payment on the set of loans, and/or a number of borrowers on the set of loans. In certain embodiments, the risks and/or obligations of the set of loans may be individualized (e.g., each borrower and/or lender is related to specific loans of the set of loans), apportioned (e.g., a default on a particular loan has an associated loss apportioned between the lenders), and/or combinations of these (e.g., one or more subsets of the set of loans is treated individually and/or apportioned).

Certain agreements may not be considered a loan. An agreement to transfer or borrow assets may not be a loan depending on what assets are transferred, how the assets were transferred, or the parties involved. For example, in some cases, the transfer of assets may be for an indefinite time and may be considered a sale of the asset or a permanent transfer. Likewise, if an asset is borrowed or transferred without clear or definite terms or lack of consensus between the lender and the borrower it may, in some cases, not be considered a loan. An agreement may be considered a loan even if a formal agreement is not directly codified in a written agreement as long as the parties willingly and knowingly agreed to the arrangement, and/or ordinary practices (e.g., in a particular industry) may treat the transaction as a loan. Accordingly, the benefits of the present disclosure may be applied in a wide variety of agreements, and any such agreement may be considered a loan herein, while in certain embodiments a given agreement may not be considered a loan herein. One of skill in the art, having the benefit of the disclosure herein and knowledge about contemplated loans ordinarily available to that person, can readily determine which aspects of the present disclosure implement a loan, utilize a loan, or benefit a particular loan transaction. Certain considerations for the person of skill in the art, in determining whether a contemplated data is a loan and/or whether aspects of the present disclosure can benefit or enhance the contemplated loan include, without limitation: the value of the assets involved, the ability of the borrower to return or repay the loan, the types of assets involved (e.g., whether the asset is consumed through utilization), the repayment time frame associated with the loan, the interest on the loan, how the agreement of the loan was arranged, formality of the agreement, detail of the agreement, the detail of the agreements of the loan, the collateral attributes associated with the loan, and/or the ordinary business expectations of any of the foregoing in a particular context. While specific examples of loans and considerations are described herein for purposes of illustration, any system benefitting from the disclosures herein, and any considerations understood to one of skill in the art having the benefit of the disclosures herein, are specifically contemplated within the scope of the present disclosure.

The term loan related event(s) (and similar terms, including loan-related events) as utilized herein should be understood broadly. Without limitation to any other aspect or description of the present disclosure, a loan related events may include any event related to terms of the loan or events triggered by the agreement associated with the loan. Loan-related events may include default on loan, breach of contract, fulfillment, repayment, payment, change in interest, late fee assessment, refund assessment, distribution, and the like. Loan-related events may be triggered by explicit agreement terms; for example, an agreement may specify a rise in interest rate after a time period has elapsed from the beginning of the loan; the rise in interest rate triggered by the agreement may be a loan related event. Loan-related events may be triggered implicitly by related loan agreement terms. In certain embodiments, any occurrence that may be considered relevant to assumptions of the loan agreement, and/or expectations of the parties to the loan agreement, may be considered an occurrence of an event. For example, if collateral for a loan is expected to be replaceable (e.g., an inventory as collateral), then a change in inventory levels may be considered an occurrence of a loan related event. In another example, if review and/or confirmation of the collateral is expected, then a lack of access to the collateral, the disablement or failure of a monitoring sensor, etc. may be considered an occurrence of a loan related event. In certain embodiments, circuits, controllers, or other devices described herein may automatically trigger the determination of a loan-related events. In some embodiments, loan-related events may be triggered by entities that manage loans or loan-related contracts. Loan-related events may be conditionally triggered based on one or more conditions in the loan agreement. Loan related events may be related to tasks or requirements that need to be completed by the lender, borrower, or a third party. Certain events may be considered loan-related events in certain embodiments and/or in certain contexts, but may not be considered a loan-related event in another embodiment or context. Many events may be associated with loans but may be caused by external triggers not associated with a loan. However, in certain embodiments, an externally triggered event (e.g., a commodity price change related to a collateral item) may be loan-related events. For example, renegotiation of loan terms initiated by a lender may not be considered a loan related event if the terms and/or performance of the existing loan agreement did not trigger the renegotiation. Accordingly, the benefits of the present disclosure may be applied in a wide variety of events, and any such event may be considered a loan related event herein, while in certain embodiments given events may not be considered a loan related event herein. One of skill in the art, having the benefit of the disclosure herein and knowledge about a contemplated system ordinarily available to that person, can readily determine which aspects of the present disclosure may be considered a loan-related event for the contemplated system and/or for particular transactions supported by the system. Certain considerations for the person of skill in the art, in determining whether a contemplated data is a loan related event and/or whether aspects of the present disclosure can benefit or enhance the contemplated transaction system include, without limitation: the impact of the related event on the loan (events that cause default or termination of the loan may have higher impact), the cost (capital and/or operating) associated with the event, the cost (capital and/or operating) associated with monitoring for an occurrence of the event, the entities responsible for responding to the event, a time period and/or response time associated with the event (e.g., time required to complete the event and time that is allotted from the time the event is triggered to when processing or detection of the event is desired to occur), the entity responsible for the event, the data required for processing the event (e.g., confidential information may have different safeguards or restrictions), the availability of mitigating actions if an undetected event occurs, and/or the remedies available to an at-risk party if the event occurs without detection. While specific examples of loan-related events and considerations are described herein for purposes of illustration, any system benefitting from the disclosures herein, and any considerations understood to one of skill in the art having the benefit of the disclosures herein, are specifically contemplated within the scope of the present disclosure.

The term loan-related activities (and similar terms) as utilized herein should be understood broadly. Without limitation to any other aspect or description of the present disclosure, a loan related activity may include activities related to the generation, maintenance, termination, collection, enforcement, servicing, billing, marketing, ability to perform, or negotiation of a loan. Loan-related activity may include activities related to the signing of a loan agreement or a promissory note, review of loan documents, processing of payments, evaluation of collateral, evaluation of compliance of the borrower or lender to the loan terms, renegotiation of terms, perfection of security or collateral for the loan, and/or a negation of terms. Loan-related activities may relate to events associated with a loan before formal agreement on the terms, such as activities associated with initial negotiations. Loan-related activities may relate to events during the life of the loan and after the termination of a loan. Loan-related activities may be performed by a lender, borrower, or a third party. Certain activities may not be considered loan related activities services individually but may be considered loan related activities based on the specificity of the activity to the loan lifecycle—for example, billing or invoicing related to outstanding loans may be considered a loan related activity, however when the invoicing or billing of loans is combined with billing or invoicing for non loan-related elements the invoicing may not be considered a loan related activity. Some activities may be performed in relation to an asset regardless of whether a loan is associated with the asset; in these cases, the activity may not be considered a loan related activity. For example, regular audits related to an asset may occur regardless of whether the asset is associated with a loan and may not be considered a loan related activity. In another example, a regular audit related to an asset may be required by a loan agreement and would not typically occur but for the association with a loan, in this case, the activity may be considered a loan related activity. In some embodiments, activities may be considered loan-related activities if the activity would otherwise not occur if the loan is not active or present, but may still be considered a loan-related activity in some instances (e.g., if auditing occurs normally, but the lender does not have the ability to enforce or review the audit, then the audit may be considered a loan-related activity even though it already occurs otherwise). Accordingly, the benefits of the present disclosure may be applied in a wide variety of events, and any such event may be considered a loan related event herein, while in certain embodiments given events may not be considered a loan related events herein. One of skill in the art, having the benefit of the disclosure herein and knowledge about a contemplated system ordinarily available to that person, can readily determine a loan related activity for the purposes of the contemplated system. Certain considerations for the person of skill in the art, in determining whether a contemplated data is a loan related activity and/or whether aspects of the present disclosure can benefit or enhance the contemplated loan include, without limitation: the necessity of the activity for the loan (can the loan agreement or terms be satisfied without the activity), the cost of the activity, the specificity of the activity to the loan (is the activity similar or identical to other industries), time involved in the activity, the impact of the activity on a loan life cycle, entity performing the activity, amount of data required for the activity (does the activity require confidential information related to the loan, or personal information related to the entities), and/or the ability of parties to enforce and/or review the activity. While specific examples of loan-related events and considerations are described herein for purposes of illustration, any system benefitting from the disclosures herein, and any considerations understood to one of skill in the art having the benefit of the disclosures herein, are specifically contemplated within the scope of the present disclosure.

The terms loan-terms, loan terms, terms for a loan, terms and conditions, and the like as utilized herein should be understood broadly (“loan terms”). Without limitation to any other aspect or description of the present disclosure, loan terms may relate to conditions, rules, limitations, contract obligations, and the like related to the timing, repayment, origination, and other enforceable conditions agreed to by the borrower and the lender of the loan. Loan terms may be specified in a formal contract between a borrower and the lender. Loan terms may specify aspects of an interest rate, collateral, foreclose conditions, consequence of debt, payment options, payment schedule, a covenant, and the like. Loan terms may be negotiable or may change during the life of a loan. Loan terms may be change or be affected by outside parameters such as market prices, bond prices, conditions associated with a lender or borrower, and the like. Certain aspects of a loan may not be considered loan terms. In certain embodiments, aspects of loan that have not been formally agreed upon between a lender and a borrower, and/or that are not ordinarily understood in the course of business (and/or the particular industry) may not be considered loan terms. Certain aspects of a loan may be preliminary or informal until they have been formally agreed or confirmed in a contract or a formal agreement. Certain aspects of a loan may not be considered loan terms individually but may not be considered loan terms based on the specificity of the aspect to a specific loan. Certain aspects of a loan may not be considered loan terms at a particular time during the loan, but may be considered loan terms at another time during the loan (e.g., obligations and/or waivers that may occur through the performance of the parties, and/or expiration of a loan term). For example, an interest rate may generally not be considered a loan term until it is defined in relation of a loan and defined as to how the interest compounded (annual, monthly), calculated, and the like. An aspect of a loan may not be considered a term if it is indefinite or unenforceable. Some aspects may be manifestations or related to terms of a loan but may themselves not be the terms. For example, a loan term may be the repayment period of a loan, such as one year. The term may not specify how the loan is to be repaid in the year. The loan may be repaid with 12 monthly payments or one annual payment. A monthly payment plan in this case may not be considered a loan term as it can be just one or many options for repayment not directly specified by a loan. Accordingly, the benefits of the present disclosure may be applied in a wide variety of loan aspects, and any such aspect may be considered a loan term herein, while in certain embodiments given aspects may not be considered loan terms herein. One of skill in the art, having the benefit of the disclosure herein and knowledge about a contemplated system ordinarily available to that person, can readily determine which aspects of the present disclosure are loan terms for the contemplated system.

Certain considerations for the person of skill in the art, in determining whether a contemplated data is a loan term and/or whether aspects of the present disclosure can benefit or enhance the contemplated loan include, without limitation: the enforceability of the terms (can the conditions be enforced by the lender or the lender or the borrower), the cost of enforcing the terms (amount of time, or effort required ensure the conditions are being followed), the complexity of the terms (how easily can they be followed or understood by the parties involved, are the terms error prone or easily misunderstood), entities responsible for the terms, fairness of the terms, stability of the terms (how often do they change), observability of the terms (can the terms be verified by a another party), favorability of the terms to one party (do the terms favor the borrower or the lender), risk associated with the loan (terms may depend on the probability that the loan may not be repaid), characteristics of the borrower or lender (their ability to meet the terms), and/or ordinary expectations for the loan and/or related industry.

While specific examples of loan terms are described herein for purposes of illustration, any system benefitting from the disclosures herein, and any considerations understood to one of skill in the art having the benefit of the disclosures herein, are specifically contemplated within the scope of the present disclosure.

The term loan conditions, loan-conditions, conditions for a loan, terms and conditions, and the like as utilized herein should be understood broadly (“loan conditions”). Without limitation to any other aspect or description of the present disclosure, loan conditions may relate to rules, limits, and/or obligations related to a loan. Loan conditions may relate to rules or necessary obligations for obtaining a loan, for maintaining a loan, for applying for a loan, for transferring a loan, and the like. Loan conditions may include principal amount of debt, a balance of debt, a fixed interest rate, a variable interest rate, a payment amount, a payment schedule, a balloon payment schedule, a specification of collateral, a specification of substitutability of collateral, treatment of collateral, access to collateral, a party, a guarantee, a guarantor, a security, a personal guarantee, a lien, a duration, a covenant, a foreclose condition, a default condition, conditions related to other debts of the borrower, and a consequence of default.

Certain aspects of a loan may not be considered loan conditions. Aspects of loan that have not been formally agreed upon between a lender and a borrower, and/or that are not ordinarily understood in the course of business (and/or the particular industry), may not be considered loan conditions. Certain aspects of a loan may be preliminary or informal until they have been formally agreed or confirmed in a contract or a formal agreement. Certain aspects of a loan may not be considered loan conditions individually but may be considered loan conditions based on the specificity of the aspect to a specific loan. Certain aspects of a loan may not be considered loan conditions at a particular time during the loan, but may be considered loan conditions at another time during the loan (e.g., obligations and/or waivers that may occur through the performance of the parties, and/or expiration of a loan condition). Accordingly, the benefits of the present disclosure may be applied in a wide variety of loan aspects, and any such aspect may be considered loan conditions herein, while in certain embodiments given aspects may not be considered loan conditions herein. One of skill in the art, having the benefit of the disclosure herein and knowledge about a contemplated system ordinarily available to that person, can readily determine which aspects of the present disclosure are loan conditions for the contemplated system. Certain considerations for the person of skill in the art, in determining whether a contemplated data is a loan condition and/or whether aspects of the present disclosure can benefit or enhance the contemplated loan include, without limitation: the enforceability of the condition (can the conditions be enforced by the lender or the lender or the borrower), the cost of enforcing the condition (amount of time, or effort required ensure the conditions are being followed), the complexity of the condition (how easily can they be followed or understood by the parties involved, are the conditions error prone or easily misunderstood), entities responsible for the conditions, fairness of the conditions, observability of the conditions (can the conditions be verified by a another party), favorability of the conditions to one party (do the conditions favor the borrower or the lender), risk associated with the loan (conditions may depend on the probability that the loan may not be repaid), and/or ordinary expectations for the loan and/or related industry.

While specific examples of loan conditions are described herein for purposes of illustration, any system benefitting from the disclosures herein, and any considerations understood to one of skill in the art having the benefit of the disclosures herein, are specifically contemplated within the scope of the present disclosure.

The term loan collateral, collateral, item of collateral, collateral item, and the like as utilized herein should be understood broadly. Without limitation to any other aspect or description of the present disclosure, a loan collateral may relate to any asset or property that a borrower promises to a lender as backup in exchange for a loan, and/or as security for the loan. Collateral may be any item of value that is accepted as an alternate form of repayment in case of default on a loan. Collateral may include any number of physical or virtual items such as a vehicle, a ship, a plane, a building, a home, real estate property, undeveloped land, a farm, a crop, a municipal facility, a warehouse, a set of inventory, a commodity, a security, a currency, a token of value, a ticket, a cryptocurrency, a consumable item, an edible item, a beverage, a precious metal, an item of jewelry, a gemstone, an item of intellectual property, an intellectual property right, a contractual right, an antique, a fixture, an item of furniture, an item of equipment, a tool, an item of machinery, and an item of personal property. Collateral may include more than one item or types of items.

A collateral item may describe an asset, a property, a value, or other item defined as a security for a loan or a transaction. A set of collateral items may be defined, and within that set substitution, removal or addition of collateral items may be affected. For example, a collateral item may be, without limitation: a vehicle, a ship, a plane, a building, a home, real estate property, undeveloped land, a farm, a crop, a municipal facility, a warehouse, a set of inventory, a commodity, a security, a currency, a token of value, a ticket, a cryptocurrency, a consumable item, an edible item, a beverage, a precious metal, an item of jewelry, a gemstone, an item of intellectual property, an intellectual property right, a contractual right, an antique, a fixture, an item of furniture, an item of equipment, a tool, an item of machinery, or an item of personal property, or the like. If a set or plurality of collateral items is defined, substitution, removal or addition of collateral items may be affected, such as substituting, removing, or adding a collateral item to or from a set of collateral items. Without limitation to any other aspect or description of the present disclosure, a collateral item or set of collateral items may also be used in conjunction with other terms to an agreement or loan, such as a representation, a warranty, an indemnity, a covenant, a balance of debt, a fixed interest rate, a variable interest rate, a payment amount, a payment schedule, a balloon payment schedule, a specification of collateral, a specification of substitutability of collateral, a security, a personal guarantee, a lien, a duration, a foreclose condition, a default condition, and a consequence of default. In certain embodiments, a smart contract may calculate whether a borrower has satisfied conditions or covenants and in cases where the borrower has not satisfied such conditions or covenants, may enable automated action, or trigger another conditions or terms that may affect the status, ownership, or transfer of a collateral item, or initiate the substitution, removal, or addition of collateral items to a set of collateral for a loan. One of skill in the art, having the benefit of the disclosure herein and knowledge about collateral items, can readily determine the purposes and use of collateral items in various embodiments and contexts disclosed herein, including the substitution, removal, and addition thereof.

While specific examples of loan collateral are described herein for purposes of illustration, any system benefitting from the disclosures herein, and any considerations understood to one of skill in the art having the benefit of the disclosures herein, are specifically contemplated within the scope of the present disclosure.

The term smart contract services (and similar terms) as utilized herein should be understood broadly. Without limitation to any other aspect or description of the present disclosure, a smart contract service includes any service or application that manages a smart contract or a smart lending contract. For example, the smart contract service may specify terms and conditions of a smart contract, such as in a rules database, or process output from a set of valuation services and assign items of collateral sufficient to provide security for a loan. Smart contract services may automatically execute a set of rules or conditions that embody the smart contract, wherein the execution may be based on or take advantage of collected data. Smart contract services may automatically initiate a demand for payment of a loan, automatically initiate a foreclosure process, automatically initiate an action to claim substitute or backup collateral or transfer ownership of collateral, automatically initiate an inspection process, automatically change a payment, or interest rate term that is based on the collateral, and may also configure smart contracts to automatically undertake a loan-related action. Smart contracts may govern at least one of loan terms and conditions, loan-related events, and loan-related activities. Smart contracts may be agreements that are encoded as computer protocols and may facilitate, verify, or enforce the negotiation or performance of a smart contract. Smart contracts may or may not be one or more of partially or fully self-executing, or partially or fully self-enforcing.

Certain processes may not be considered to be smart-contract related individually, but may be considered smart-contract related in an aggregated system—for example automatically undertaking a loan-related action may not be smart contract-related in one instance, but in another instance, may be governed by terms of a smart contract. Accordingly, the benefits of the present disclosure may be applied in a wide variety of processes systems, and any such processes or systems may be considered a smart contract or smart contract service herein, while in certain embodiments a given service may not be considered a smart contract service herein.

One of skill in the art, having the benefit of the disclosure herein and knowledge about a contemplated system ordinarily available to that person, can readily determine which aspects of the present disclosure will benefit a particular system and how to combine processes and systems from the present disclosure to implement a smart contract service and/or enhance operations of the contemplated system. Certain considerations for the person of skill in the art, in determining whether a contemplated system includes a smart contract service or smart contract and/or whether aspects of the present disclosure can benefit or enhance the contemplated system include, without limitation: ability to transfer ownership of collateral automatically in response to an event; automated actions available upon a finding of covenant compliance (or lack of compliance); the amenity of the collateral to clustering, re-balancing, distribution, addition, substitution, and removal of items from collateral; the modification parameters of an aspect of a loan in response to an event (e.g., timing, complexity, suitability for the loan type, etc.); the complexity of terms and conditions of loans for the system, including benefits from rapid determination and/or predictions of changes to entities (e.g., in the collateral, a financial condition of a party, offset collateral, and/or in an industry related to a party) related to the loan; the suitability of automated generation of terms and conditions and/or execution of terms and conditions for the types of loans, parties, and/or industries contemplated for the system; and the like. While specific examples of smart contract services and considerations are described herein for purposes of illustration, any system benefitting from the disclosures herein, and any considerations understood to one of skill in the art having the benefit of the disclosures herein, are specifically contemplated within the scope of the present disclosure.

The term IoT system (and similar terms) as utilized herein should be understood broadly. Without limitation to any other aspect or description of the present disclosure, an IoT system includes any system of uniquely identified and interrelated computing devices, mechanical and digital machines, sensors, and objects that are able to transfer data over a network without intervention. Certain components may not be considered an IoT system individually, but may be considered an IoT system in an aggregated system, for example, a single networked.

The sensor, smart speaker, and/or medical device may be not an IoT system, but may be a part of a larger system and/or be accumulated with a number of other similar components to be considered an IoT system and/or a part of an IoT system. In certain embodiments, a system may be considered an IoT system for some purposes but not for other purposes—for example, a smart speaker may be considered part of an IoT system for certain operations, such as for providing surround sound, or the like, but not part of an IoT system for other operations such as directly streaming content from a single, locally networked source. Additionally, in certain embodiments, otherwise similar looking systems may be differentiated in determining whether such systems are IoT systems, and/or which type of IoT system. For example, one group of medical devices may not, at a given time, be sharing to an aggregated HER database, while another group of medical devices may be sharing data to an aggregate HER for the purposes of a clinical study, and accordingly one group of medical devices may be an IoT system, while the other is not. Accordingly, the benefits of the present disclosure may be applied in a wide variety of systems, and any such systems may be considered an IoT system herein, while in certain embodiments a given system may not be considered an IoT system herein. One of skill in the art, having the benefit of the disclosure herein and knowledge about a contemplated system ordinarily available to that person, can readily determine which aspects of the present disclosure will benefit a particular system, how to combine processes and systems from the present disclosure to enhance operations of the contemplated system, and which circuits, controllers, and/or devices include an IoT system for the contemplated system. Certain considerations for the person of skill in the art, in determining whether a contemplated system is an IoT system and/or whether aspects of the present disclosure can benefit or enhance the contemplated system include, without limitation: the transmission environment of the system (e.g., availability of low power, inter-device networking); the shared data storage of a group of devices; establishment of a geofence by a group of devices; service as blockchain nodes; the performance of asset, collateral, or entity monitoring; the relay of data between devices; ability to aggregate data from a plurality of sensors or monitoring devices, and the like. While specific examples of IoT systems and considerations are described herein for purposes of illustration, any system benefitting from the disclosures herein, and any considerations understood to one of skill in the art having the benefit of the disclosures herein, are specifically contemplated within the scope of the present disclosure.

The term data collection services (and similar terms) as utilized herein should be understood broadly. Without limitation to any other aspect or description of the present disclosure, a data collection service includes any service that collects data or information, including any circuit, controller, device, or application that may store, transmit, transfer, share, process, organize, compare, report on and/or aggregate data. The data collection service may include data collection devices (e.g., sensors) and/or may be in communication with data collection devices. The data collection service may monitor entities, such as to identify data or information for collection. The data collection service may be event-driven, run on a periodic basis, or retrieve data from an application at particular points in the application's execution. Certain processes may not be considered to be a data collection service individually, but may be considered a data collection service in an aggregated system—for example, a networked storage device may be a component of a data collection service in one instance, but in another instance, may have stand-alone functionality. Accordingly, the benefits of the present disclosure may be applied in a wide variety of processes systems, and any such processes or systems may be considered a data collection service herein, while in certain embodiments a given service may not be considered a data collection service herein. One of skill in the art, having the benefit of the disclosure herein and knowledge about a contemplated system ordinarily available to that person, can readily determine which aspects of the present disclosure will benefit a particular system and how to combine processes and systems from the present disclosure implement a data collection service and/or to enhance operations of the contemplated system. Certain considerations for the person of skill in the art, in determining whether a contemplated system is a data collection service and/or whether aspects of the present disclosure can benefit or enhance the contemplated system include, without limitation: ability to modify a business rule on the fly and alter a data collection protocol; perform real-time monitoring of events; connection of a device for data collection to a monitoring infrastructure, execution of computer readable instructions that cause a processor to log or track events; use of an automated inspection system; occurrence of sales at a networked point-of-sale; need for data from one or more distributed sensors or cameras; and the like. While specific examples of data collection services and considerations are described herein for purposes of illustration, any system benefitting from the disclosures herein, and any considerations understood to one of skill in the art having the benefit of the disclosures herein, are specifically contemplated within the scope of the present disclosure.

The term data integration services (and similar terms) as utilized herein should be understood broadly. Without limitation to any other aspect or description of the present disclosure, a data integration service includes any service that integrates data or information, including any device or application that may extract, transform, load, normalize, compress, decompress, encode, decode, and otherwise process data packets, signals, and other information. The data integration service may monitor entities, such as to identify data or information for integration. The data integration service may integrate data regardless of required frequency, communication protocol, or business rules needed for intricate integration patterns. Accordingly, the benefits of the present disclosure may be applied in a wide variety of processes systems, and any such processes or systems may be considered a data integration service herein, while in certain embodiments a given service may not be considered a data integration service herein. One of skill in the art, having the benefit of the disclosure herein and knowledge about a contemplated system ordinarily available to that person, can readily determine which aspects of the present disclosure will benefit a particular system and how to combine processes and systems from the present disclosure to implement a data integration service and/or enhance operations of the contemplated system. Certain considerations for the person of skill in the art, in determining whether a contemplated system is a data integration service and/or whether aspects of the present disclosure can benefit or enhance the contemplated system include, without limitation: ability to modify a business rule on the fly and alter a data integration protocol; communication with third party databases to pull in data to integrate with; synchronization of data across disparate platforms; connection to a central data warehouse; data storage capacity, processing capacity, and/or communication capacity distributed throughout the system; the connection of separate, automated workflows; and the like. While specific examples of data integration services and considerations are described herein for purposes of illustration, any system benefitting from the disclosures herein, and any considerations understood to one of skill in the art having the benefit of the disclosures herein, are specifically contemplated within the scope of the present disclosure.

The term computational services (and similar terms) as utilized herein should be understood broadly. Without limitation to any other aspect or description of the present disclosure, computational services may be included as a part of one or more services, platforms, or microservices, such as blockchain services, data collection services, data integration services, valuation services, smart contract services, data monitoring services, data mining, and/or any service that facilitates collection, access, processing, transformation, analysis, storage, visualization, or sharing of data. Certain processes may not be considered to be a computational service. For example, a process may not be considered a computational service depending on the sorts of rules governing the service, an end product of the service, or the intent of the service. Accordingly, the benefits of the present disclosure may be applied in a wide variety of processes systems, and any such processes or systems may be considered a computational service herein, while in certain embodiments a given service may not be considered a computational service herein. One of skill in the art, having the benefit of the disclosure herein and knowledge about a contemplated system ordinarily available to that person, can readily determine which aspects of the present disclosure will benefit a particular system and how to combine processes and systems from the present disclosure to implement one or more computational service, and/or to enhance operations of the contemplated system. Certain considerations for the person of skill in the art, in determining whether a contemplated system is a computational service and/or whether aspects of the present disclosure can benefit or enhance the contemplated system include, without limitation: agreement-based access to the service; mediate an exchange between different services; provides on demand computational power to a web service; accomplishes one or more of monitoring, collection, access, processing, transformation, analysis, storage, integration, visualization, mining, or sharing of data. While specific examples of computational services and considerations are described herein for purposes of illustration, any system benefitting from the disclosures herein, and any considerations understood to one of skill in the art having the benefit of the disclosures herein, are specifically contemplated within the scope of the present disclosure.

The term sensor as utilized herein should be understood broadly. Without limitation to any other aspect or description of the present disclosure, a sensor may be a device, module, machine, or subsystem that detects or measures a physical quality, event, or change. In embodiments, may record, indicate, transmit, or otherwise respond to the detection or measurement. Examples of sensors may be sensors for sensing movement of entities, for sensing temperatures, pressures or other attributes about entities or their environments, cameras that capture still or video images of entities, sensors that collect data about collateral or assets, such as, for example, regarding the location, condition (health, physical, or otherwise), quality, security, possession, or the like. In embodiments, sensors may be sensitive to, but not influential on, the property to be measured but insensitive to other properties. Sensors may be analog or digital. Sensors may include processors, transmitters, transceivers, memory, power, sensing circuit, electrochemical fluid reservoirs, light sources, and the like. Further examples of sensors contemplated for use in the system include biosensors, chemical sensors, black silicon sensor, IR sensor, acoustic sensor, induction sensor, motion sensor, optical sensor, opacity sensor, proximity sensor, inductive sensor, Eddy-current sensor, passive infrared proximity sensor, radar, capacitance sensor, capacitive displacement sensor, hall-effect sensor, magnetic sensor, GPS sensor, thermal imaging sensor, thermocouple, thermistor, photoelectric sensor, ultrasonic sensor, infrared laser sensor, inertial motion sensor, MEMS internal motion sensor, ultrasonic 3D motion sensor, accelerometer, inclinometer, force sensor, piezoelectric sensor, rotary encoders, linear encoders, ozone sensor, smoke sensor, heat sensor, magnetometer, carbon dioxide detector, carbon monoxide detector, oxygen sensor, glucose sensor, smoke detector, metal detector, rain sensor, altimeter, GPS, detection of being outside, detection of context, detection of activity, object detector (e.g., collateral), marker detector (e.g., geo-location marker), laser rangefinder, sonar, capacitance, optical response, heart rate sensor, or an RF/micropower impulse radio (MIR) sensor. In certain embodiments, a sensor may be a virtual sensor—for example determining a parameter of interest as a calculation based on other sensed parameters in the system. In certain embodiments, a sensor may be a smart sensor—for example reporting a sensed value as an abstracted communication (e.g., as a network communication) of the sensed value. In certain embodiments, a sensor may provide a sensed value directly (e.g., as a voltage level, frequency parameter, etc.) to a circuit, controller, or other device in the system. One of skill in the art, having the benefit of the disclosure herein and knowledge about a contemplated system ordinarily available to that person, can readily determine which aspects of the present disclosure will benefit from a sensor. Certain considerations for the person of skill in the art, in determining whether a contemplated device is a sensor and/or whether aspects of the present disclosure can benefit from or be enhanced by the contemplated sensor include, without limitation: the conditioning of an activation/deactivation of a system to an environmental quality; the conversion of electrical output into measured quantities; the ability to enforce a geofence; the automatic modification of a loan in response to change in collateral; and the like. While specific examples of sensors and considerations are described herein for purposes of illustration, any system benefitting from the disclosures herein, and any considerations understood to one of skill in the art having the benefit of the disclosures herein, are specifically contemplated within the scope of the present disclosure.

The term storage condition and similar terms, as utilized herein should be understood broadly. Without limitation to any other aspect or description of the present disclosure, storage condition includes an environment, physical location, environmental quality, level of exposure, security measures, maintenance description, accessibility description, and the like related to the storage of an asset, collateral, or an entity specified and monitored in a contract, loan, or agreement or backing the contract, loan or other agreement, and the like. Based on a storage condition of a collateral, an asset, or entity, actions may be taken to, maintain, improve, and/or confirm a condition of the asset or the use of that asset as collateral. Based on a storage condition, actions may be taken to alter the terms or conditions of a loan or bond. Storage condition may be classified in accordance with various rules, thresholds, conditional procedures, workflows, model parameters, and the like and may be based on self-reporting or on data from Internet of Things devices, data from a set of environmental condition sensors, data from a set of social network analytic services and a set of algorithms for querying network domains, social media data, crowdsourced data, and the like. The storage condition may be tied to a geographic location relating to the collateral, the issuer, the borrower, the distribution of the funds or other geographic locations. Examples of IoT data may include images, sensor data, location data, and the like. Examples of social media data or crowdsourced data may include behavior of parties to the loan, financial condition of parties, adherence to a party's a term or condition of the loan, or bond, or the like. Parties to the loan may include issuers of a bond, related entities, lender, borrower, 3rd parties with an interest in the debt. Storage condition may relate to an asset or type of collateral such as a municipal asset, a vehicle, a ship, a plane, a building, a home, real estate property, undeveloped land, a farm, a crop, a municipal facility, a warehouse, a set of inventory, a commodity, a security, a currency, a token of value, a ticket, a cryptocurrency, a consumable item, an edible item, a beverage, a precious metal, an item of jewelry, a gemstone, an item of intellectual property, an intellectual property right, a contractual right, an antique, a fixture, an item of furniture, an item of equipment, a tool, an item of machinery, and an item of personal property. The storage condition may include an environment where environment may include an environment selected from among a municipal environment, a corporate environment, a securities trading environment, a real property environment, a commercial facility, a warehousing facility, a transportation environment, a manufacturing environment, a storage environment, a home, and a vehicle. Actions based on the storage condition of a collateral, an asset or an entity may include managing, reporting on, altering, syndicating, consolidating, terminating, maintaining, modifying terms and/or conditions, foreclosing an asset, or otherwise handling a loan, contract, or agreement. One of skill in the art, having the benefit of the disclosure herein and knowledge about a contemplated storage condition, can readily determine which aspects of the present disclosure will benefit a particular application for a storage condition. Certain considerations for the person of skill in the art, or embodiments of the present disclosure in choosing an appropriate storage condition to manage and/or monitor, include, without limitation: the legality of the condition given the jurisdiction of the transaction, the data available for a given collateral, the anticipated transaction type (loan, bond or debt), the specific type of collateral, the ratio of the loan to value, the ratio of the collateral to the loan, the gross transaction/loan amount, the credit scores of the borrower and the lender, ordinary practices in the industry, and other considerations. While specific examples of storage conditions are described herein for purposes of illustration, any embodiment benefitting from the disclosures herein, and any considerations understood to one of skill in the art having the benefit of the disclosures herein are specifically contemplated within the scope of the present disclosure.

The term geolocation and similar terms, as utilized herein should be understood broadly. Without limitation to any other aspect or description of the present disclosure, geolocation includes the identification or estimation of the real-world geographic location of an object, including the generation of a set of geographic coordinates (e.g., latitude and longitude) and/or street address. Based on a geolocation of a collateral, an asset, or entity, actions may be taken to maintain or improve a condition of the asset or the use of that asset as collateral. Based on a geolocation, actions may be taken to alter the terms or conditions of a loan or bond. Based on a geolocation, determinations or predictions related to a transaction may be performed—for example based upon the weather, civil unrest in a particular area, and/or local disasters (e.g., an earthquake, flood, tornado, hurricane, industrial accident, etc.). Geolocations may be determined in accordance with various rules, thresholds, conditional procedures, workflows, model parameters, and the like and may be based on self-reporting or on data from Internet of Things devices, data from a set of environmental condition sensors, data from a set of social network analytic services and a set of algorithms for querying network domains, social media data, crowdsourced data, and the like. Examples of geolocation data may include GPS coordinates, images, sensor data, street address, and the like. Geolocation data may be quantitative (e.g., longitude/latitude, relative to a plat map, etc.) and/or qualitative (e.g., categorical such as “coastal”, “rural”, etc.; “within New York City”, etc.). Geolocation data may be absolute (e.g., GPS location) or relative (e.g., within 100 yards of an expected location). Examples of social media data or crowdsourced data may include behavior of parties to the loan as inferred by their geolocation, financial condition of parties inferred by geolocation, adherence of parties to a term or condition of the loan, or bond, or the like. Geolocation may be determined for an asset or type of collateral such as a municipal asset, a vehicle, a ship, a plane, a building, a home, real estate property, undeveloped land, a farm, a crop, a municipal facility, a warehouse, a set of inventory, a commodity, a security, a currency, a token of value, a ticket, a consumable item, an edible item, a beverage, a precious metal, an item of jewelry, a gemstone, an antique, a fixture, an item of furniture, an item of equipment, a tool, an item of machinery, and an item of personal property. Geolocation may be determined for an entity such as one of the parties, a third-party (e.g., an inspection service, maintenance service, cleaning service, etc. relevant to a transaction), or any other entity related to a transaction. The geolocation may include an environment selected from among a municipal environment, a corporate environment, a securities trading environment, a real property environment, a commercial facility, a warehousing facility, a transportation environment, a manufacturing environment, a storage environment, a home, and a vehicle. Actions based on the geolocation of a collateral, an asset or an entity may include managing, reporting on, altering, syndicating, consolidating, terminating, maintaining, modifying terms and/or conditions, foreclosing an asset, or otherwise handling a loan, contract, or agreement. One of skill in the art, having the benefit of the disclosure herein and knowledge about a contemplated system, can readily determine which aspects of the present disclosure will benefit a particular application for a geolocation, and which location aspect of an item is a geolocation for the contemplated system. Certain considerations for the person of skill in the art, or embodiments of the present disclosure in choosing an appropriate geolocation to manage, include, without limitation: the legality of the geolocation given the jurisdiction of the transaction, the data available for a given collateral, the anticipated transaction type (loan, bond or debt), the specific type of collateral, the ratio of the loan to value, the ratio of the collateral to the loan, the gross transaction/loan amount, the frequency of travel of the borrower to certain jurisdictions and other considerations, the mobility of the collateral, and/or a likelihood of location-specific event occurrence relevant to the transaction (e.g., weather, location of a relevant industrial facility, availability of relevant services, etc.). While specific examples of geolocation are described herein for purposes of illustration, any embodiment benefitting from the disclosures herein, and any considerations understood to one of skill in the art having the benefit of the disclosures herein are specifically contemplated within the scope of the present disclosure.

The term jurisdictional location and similar terms, as utilized herein should be understood broadly. Without limitation to any other aspect or description of the present disclosure, jurisdictional location refers to the laws and legal authority governing a loan entity. The jurisdictional location may be based on a geolocation of an entity, a registration location of an entity (e.g., a ship's flag state, a state of incorporation for a business, and the like), a granting state for certain rights such as intellectual priority, and the like. In certain embodiments, a jurisdictional location may be one or more of the geolocations for an entity in the system. In certain embodiments, a jurisdictional location may not be the same as the geolocation of any entity in the system (e.g., where an agreement specifies some other jurisdiction). In certain embodiments, a jurisdictional location may vary for entities in the system (e.g., borrower at A, lender at B, collateral positioned at C, agreement enforced at D, etc.). In certain embodiments, a jurisdictional location for a given entity may vary during the operations of the system (e.g., due to movement of collateral, related data, changes in terms and conditions, etc.). In certain embodiments, a given entity of the system may have more than one jurisdictional location (e.g., due to operations of the relevant law, and/or options available to one or more parties), and/or may have distinct jurisdictional locations for different purposes. A jurisdictional location of an item of collateral, an asset, or entity, actions may dictate certain terms or conditions of a loan or bond, and/or may indicate different obligations for notices to parties, foreclosure and/or default execution, treatment of collateral and/or debt security, and/or treatment of various data within the system. While specific examples of jurisdictional location are described herein for purposes of illustration, any embodiment benefitting from the disclosures herein, and any considerations understood to one of skill in the art having the benefit of the disclosures herein are specifically contemplated within the scope of the present disclosure.

The terms token of value, token, and variations such as cryptocurrency token, and the like, as utilized herein, in the context of increments of value, may be understood broadly to describe either: (a) a unit of currency or cryptocurrency (e.g., a cryptocurrency token), and (b) may also be used to represent a credential that can be exchanged for a good, service, data or other valuable consideration (e.g., a token of value). Without limitation to any other aspect or description of the present disclosure, in the former case, a token may also be used in conjunction with investment applications, token-trading applications, and token-based marketplaces. In the latter case, a token can also be associated with rendering consideration, such as providing goods, services, fees, access to a restricted area or event, data, or other valuable benefit. Tokens can be contingent (e.g., contingent access token) or not contingent. For example, a token of value may be exchanged for accommodations, (e.g., hotel rooms), dining/food goods and services, space (e.g., shared space, workspace, convention space, etc.), fitness/wellness goods or services, event tickets or event admissions, travel, flights or other transportation, digital content, virtual goods, license keys, or other valuable goods, services, data, or consideration. Tokens in various forms may be included where discussing a unit of consideration, collateral, or value, whether currency, cryptocurrency, or any other form of value such as goods, services, data, or other benefits. One of skill in the art, having the benefit of the disclosure herein and knowledge about a token, can readily determine the value symbolized or represented by a token, whether currency, cryptocurrency, good, service, data, or other value. While specific examples of tokens are described herein for purposes of illustration, any embodiment benefitting from the disclosures herein, and any considerations understood to one of skill in the art having the benefit of the disclosures herein, are specifically contemplated within the scope of the present disclosure.

The term pricing data as utilized herein may be understood broadly to describe a quantity of information such as a price or cost, of one or more items in a marketplace. Without limitation to any other aspect or description of the present disclosure, pricing data may also be used in conjunction with spot market pricing, forward market pricing, pricing discount information, promotional pricing, and other information relating to the cost or price of items. Pricing data may satisfy one or more conditions, or may trigger application of one or more rules of a smart contract. Pricing data may be used in conjunction with other forms of data such as market value data, accounting data, access data, asset and facility data, worker data, event data, underwriting data, claims data or other forms of data. Pricing data may be adjusted for the context of the valued item (e.g., condition, liquidity, location, etc.) and/or for the context of a particular party. One of skill in the art, having the benefit of the disclosure herein and knowledge about pricing data, can readily determine the purposes and use of pricing data in various embodiments and contexts disclosed herein.

Without limitation to any other aspect or description of the present disclosure, a token includes any token including, without limitation, a token of value, such as collateral, an asset, a reward, such as in a token serving as representation of value, such as a value holding voucher that can be exchanged for goods or services. Certain components may not be considered tokens individually, but may be considered tokens in an aggregated system, for example, a value placed on an asset may not be in itself be a token, but the value of an asset may be placed in a token of value, such as to be stored, exchanged, traded, and the like. For instance, in a non-limiting example, a blockchain circuit may be structured to provide lenders a mechanism to store the value of assets, where the value attributed to the token is stored in a distributed ledger of the blockchain circuit, but the token itself, assigned the value, may be exchanged, or traded such as through a token marketplace. In certain embodiments, a token may be considered a token for some purposes but not for other purposes—for example, a token may be used as an indication of ownership of an asset, but this use of a token would not be traded as a value where a token including the value of the asset might. Accordingly, the benefits of the present disclosure may be applied in a wide variety of systems, and any such systems may be considered a token herein, while in certain embodiments a given system may not be considered a token herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is a token and/or whether aspects of the present disclosure can benefit or enhance the contemplated system include, without limitation, access data such as relating to rights of access, tickets, and tokens; use in an investment application such as for investment in shares, interests, and tokens; a token-trading application; a token-based marketplace; forms of consideration such as monetary rewards and tokens; translating the value of a resources in tokens; a cryptocurrency token; indications of ownership such as identity information, event information, and token information; a blockchain-based access token traded in a marketplace application; pricing application such as for setting and monitoring pricing for contingent access rights, underlying access rights, tokens, and fees; trading applications such as for trading or exchanging contingent access rights or underlying access rights or tokens; tokens created and stored on a blockchain for contingent access rights resulting in an ownership (e.g., a ticket); and the like.

The term financial data as utilized herein may be understood broadly to describe a collection of financial information about an asset, collateral or other item or items. Financial data may include revenues, expenses, assets, liabilities, equity, bond ratings, default, return on assets (ROA), return on investment (ROI), past performance, expected future performance, earnings per share (EPS), internal rate of return (IRR), earnings announcements, ratios, statistical analysis of any of the foregoing (e.g., moving averages), and the like. Without limitation to any other aspect or description of the present disclosure, financial data may also be used in conjunction with pricing data and market value data. Financial data may satisfy one or more conditions, or may trigger application of one or more rules of a smart contract. Financial data may be used in conjunction with other forms of data such as market value data, pricing data, accounting data, access data, asset and facility data, worker data, event data, underwriting data, claims data or other forms of data. One of skill in the art, having the benefit of the disclosure herein and knowledge about financial data, can readily determine the purposes and use of pricing data in various embodiments and contexts disclosed herein.

The term covenant as utilized herein may be understood broadly to describe a term, agreement, or promise, such as performance of some action or inaction. For example, a covenant may relate to behavior of a party or legal status of a party. Without limitation to any other aspect or description of the present disclosure, a covenant may also be used in conjunction with other related terms to an agreement or loan, such as a representation, a warranty, an indemnity, a balance of debt, a fixed interest rate, a variable interest rate, a payment amount, a payment schedule, a balloon payment schedule, a specification of collateral, a specification of substitutability of collateral, a party, a guarantee, a guarantor, a security, a personal guarantee, a lien, a duration, a foreclose condition, a default condition, and a consequence of default. A covenant or lack of performance of a covenant may satisfy one or more conditions, or may trigger collection, breach or other terms and conditions. In certain embodiments, a smart contract may calculate whether a covenant is satisfied and in cases where the covenant is not satisfied, may enable automated action, or trigger other conditions or terms. One of skill in the art, having the benefit of the disclosure herein and knowledge about covenants, can readily determine the purposes and use of covenants in various embodiments and contexts disclosed herein.

The term entity as utilized herein may be understood broadly to describe a party, a third-party (e.g., an auditor, regulator, service provider, etc.), and/or an identifiable related object such as an item of collateral related to a transaction. Example entities include an individual, partnership, corporation, limited liability company or other legal organization. Other example entities include an identifiable item of collateral, offset collateral, potential collateral, or the like. For example, an entity may be a given party, such as an individual, to an agreement or loan. Data or other terms herein may be characterized as having a context relating to an entity, such as entity-oriented data. An entity may be characterized with a specific context or application, such as a human entity, physical entity, transactional entity, or a financial entity, without limitation. An entity may have representatives that represent or act on its behalf. Without limitation to any other aspect or description of the present disclosure, an entity may also be used in conjunction with other related entities or terms to an agreement or loan, such as a representation, a warranty, an indemnity, a covenant, a balance of debt, a fixed interest rate, a variable interest rate, a payment amount, a payment schedule, a balloon payment schedule, a specification of collateral, a specification of substitutability of collateral, a party, a guarantee, a guarantor, a security, a personal guarantee, a lien, a duration, a foreclose condition, a default condition, and a consequence of default. An entity may have a set of attributes such as: a publicly stated valuation, a set of property owned by the entity as indicated by public records, a valuation of a set of property owned by the entity, a bankruptcy condition, a foreclosure status, a contractual default status, a regulatory violation status, a criminal status, an export controls status, an embargo status, a tariff status, a tax status, a credit report, a credit rating, a website rating, a set of customer reviews for a product of an entity, a social network rating, a set of credentials, a set of referrals, a set of testimonials, a set of behavior, a location, and a geolocation, without limitation. In certain embodiments, a smart contract may calculate whether an entity has satisfied conditions or covenants and in cases where the entity has not satisfied such conditions or covenants, may enable automated action, or trigger other conditions or terms. One of skill in the art, having the benefit of the disclosure herein and knowledge about entities, can readily determine the purposes and use of entities in various embodiments and contexts disclosed herein.

The term party as utilized herein may be understood broadly to describe a member of an agreement, such as an individual, partnership, corporation, limited liability company or other legal organization. For example, a party may be a primary lender, a secondary lender, a lending syndicate, a corporate lender, a government lender, a bank lender, a secured lender, a bond issuer, a bond purchaser, an unsecured lender, a guarantor, a provider of security, a borrower, a debtor, an underwriter, an inspector, an assessor, an auditor, a valuation professional, a government official, an accountant or other entities having rights or obligations to an agreement, transaction or loan. A party may characterize a different term, such as transaction as in the term multi-party transaction, where multiple parties are involved in a transaction, or the like, without limitation. A party may have representatives that represent or act on its behalf. In certain embodiments, the term party may reference a potential party or a prospective party—for example, an intended lender or borrower interacting with a system, that may not yet be committed to an actual agreement during the interactions with the system. Without limitation to any other aspect or description of the present disclosure, an party may also be used in conjunction with other related parties or terms to an agreement or loan, such as a representation, a warranty, an indemnity, a covenant, a balance of debt, a fixed interest rate, a variable interest rate, a payment amount, a payment schedule, a balloon payment schedule, a specification of collateral, a specification of substitutability of collateral, an entity, a guarantee, a guarantor, a security, a personal guarantee, a lien, a duration, a foreclose condition, a default condition, and a consequence of default. A party may have a set of attributes such as: an identity, a creditworthiness, an activity, a behavior, a business practice, a status of performance of a contract, information about accounts receivable, information about accounts payable, information about the value of collateral, and other types of information, without limitation. In certain embodiments, a smart contract may calculate whether a party has satisfied conditions or covenants and in cases where the party has not satisfied such conditions or covenants, may enable automated action, or trigger other conditions or terms. One of skill in the art, having the benefit of the disclosure herein and knowledge about parties, can readily determine the purposes and use of parties in various embodiments and contexts disclosed herein.

The term party attribute, entity attribute, or party/entity attribute as utilized herein may be understood broadly to describe a value, characteristic, or status of a party or entity. For example, attributes of a party or entity may be, without limitation: value, quality, location, net worth, price, physical condition, health condition, security, safety, ownership, identity, creditworthiness, activity, behavior, business practice, status of performance of a contract, information about accounts receivable, information about accounts payable, information about the value of collateral, and other types of information, and the like. In certain embodiments, a smart contract may calculate values, status or conditions associated with attributes of a party or entity, and in cases where the party or entity has not satisfied such conditions or covenants, may enable automated action, or trigger other conditions or terms. One of skill in the art, having the benefit of the disclosure herein and knowledge about attributes of a party or entity, can readily determine the purposes and use of these attributes in various embodiments and contexts disclosed herein.

The term lender as utilized herein may be understood broadly to describe a party to an agreement offering an asset for lending, proceeds of a loan, and may include an individual, partnership, corporation, limited liability company, or other legal organization. For example, a lender may be a primary lender, a secondary lender, a lending syndicate, a corporate lender, a government lender, a bank lender, a secured lender, an unsecured lender, or other party having rights or obligations to an agreement, transaction or loan offering a loan to a borrower, without limitation. A lender may have representatives that represent or act on its behalf. Without limitation to any other aspect or description of the present disclosure, an party may also be used in conjunction with other related parties or terms to an agreement or loan, such as a borrower, a guarantor, a representation, a warranty, an indemnity, a covenant, a balance of debt, a fixed interest rate, a variable interest rate, a payment amount, a payment schedule, a balloon payment schedule, a specification of collateral, a specification of substitutability of collateral, a security, a personal guarantee, a lien, a duration, a foreclose condition, a default condition, and a consequence of default. In certain embodiments, a smart contract may calculate whether a lender has satisfied conditions or covenants and in cases where the lender has not satisfied such conditions or covenants, may enable automated action, a notification or alert, or trigger other conditions or terms. One of skill in the art, having the benefit of the disclosure herein and knowledge about a lender, can readily determine the purposes and use of a lender in various embodiments and contexts disclosed herein.

The term crowdsourcing services as utilized herein may be understood broadly to describe services offered or rendered in conjunction with a crowdsourcing model or transaction, wherein a large group of people or entities supply contributions to fulfill a need, such as a loan, for the transaction. Crowdsourcing services may be provided by a platform or system, without limitation. A crowdsourcing request may be communicated to a group of information suppliers and by which responses to the request may be collected and processed to provide a reward to at least one successful information supplier. The request and parameters may be configured to obtain information related to the condition of a set of collateral for a loan. The crowdsourcing request may be published. In certain embodiments, without limitation, crowdsourcing services may be performed by a smart contract, wherein the reward is managed by a smart contract that processes responses to the crowdsourcing request and automatically allocates a reward to information that satisfies a set of parameter configured for the crowdsourcing request. One of skill in the art, having the benefit of the disclosure herein and knowledge about crowdsourcing services, can readily determine the purposes and use of crowdsourcing services in various embodiments and contexts disclosed herein.

The term publishing services as utilized herein may be understood to describe a set of services to publish a crowdsourcing request. Publishing services may be provided by a platform or system, without limitation. In certain embodiments, without limitation, publishing services may be performed by a smart contract, wherein the crowdsourcing request is published, or publication is initiated by the smart contract. One of skill in the art, having the benefit of the disclosure herein and knowledge about publishing services, can readily determine the purposes and use of publishing services in various embodiments and contexts disclosed herein.

The term interface as utilized herein may be understood broadly to describe a component by which interaction or communication is achieved, such as a component of a computer, which may be embodied in software, hardware, or a combination thereof. For example, an interface may serve a number of different purposes or be configured for different applications or contexts, such as, without limitation: an application programming interface, a graphic user interface, user interface, software interface, marketplace interface, demand aggregation interface, crowdsourcing interface, secure access control interface, network interface, data integration interface or a cloud computing interface, or combinations thereof. An interface may serve to act as a way to enter, receive or display data, within the scope of lending, refinancing, collection, consolidation, factoring, brokering or foreclosure, without limitation. An interface may serve as an interface for another interface. Without limitation to any other aspect or description of the present disclosure, an interface may be used in conjunction with applications, processes, modules, services, layers, devices, components, machines, products, sub-systems, interfaces, connections, or as part of a system. In certain embodiments, an interface may be embodied in software, hardware, or a combination thereof, as well as stored on a medium or in memory. One of skill in the art, having the benefit of the disclosure herein and knowledge about an interface, can readily determine the purposes and use of an interface in various embodiments and contexts disclosed herein.

The term graphical user interface as utilized herein may be understood as a type of interface to allow a user to interact with a system, computer, or other interfaces, in which interaction or communication is achieved through graphical devices or representations. A graphical user interface may be a component of a computer, which may be embodied in computer readable instructions, hardware, or a combination thereof. A graphical user interface may serve a number of different purposes or be configured for different applications or contexts. Such an interface may serve to act as a way to receive or display data using visual representation, stimulus or interactive data, without limitation. A graphical user interface may serve as an interface for another graphical user interface or other interfaces. Without limitation to any other aspect or description of the present disclosure, a graphical user interface may be used in conjunction with applications, processes, modules, services, layers, devices, components, machines, products, sub-systems, interfaces, connections, or as part of a system. In certain embodiments, a graphical user interface may be embodied in computer readable instructions, hardware, or a combination thereof, as well as stored on a medium or in memory. Graphical user interfaces may be configured for any input types, including keyboards, a mouse, a touch screen, and the like. Graphical user interfaces may be configured for any desired user interaction environments, including for example a dedicated application, a web page interface, or combinations of these. One of skill in the art, having the benefit of the disclosure herein and knowledge about a graphical user interface, can readily determine the purposes and use of a graphical user interface in various embodiments and contexts disclosed herein.

The term user interface as utilized herein may be understood as a type of interface to allow a user to interact with a system, computer, or other apparatus, in which interaction or communication is achieved through graphical devices or representations. A user interface may be a component of a computer, which may be embodied in software, hardware, or a combination thereof. The user interface may be stored on a medium or in memory. User interfaces may include drop-down menus, tables, forms, or the like with default, templated, recommended, or pre-configured conditions. In certain embodiments, a user interface may include voice interaction. Without limitation to any other aspect or description of the present disclosure, a user interface may be used in conjunction with applications, circuits, controllers, processes, modules, services, layers, devices, components, machines, products, sub-systems, interfaces, connections, or as part of a system. User interfaces may serve a number of different purposes or be configured for different applications or contexts. For example, a lender-side user interface may include features to view a plurality of customer profiles, but may be restricted from making certain changes. A debtor-side user interface may include features to view details and make changes to a user account. A 3rd party neutral-side interface (e.g., a 3rd party not having an interest in an underlying transaction, such as a regulator, auditor, etc.) may have features that enable a view of company oversight and anonymized user data without the ability to manipulate any data, and may have scheduled access depending upon the 3rd party and the purpose for the access. A 3rd party interested-side interface (e.g., a 3rd party that may have an interest in an underlying transaction, such as a collector, debtor advocate, investigator, partial owner, etc.) may include features enabling a view of particular user data with restrictions on making changes. Many more features of these user interfaces may be available to implements embodiments of the systems and/or procedures described throughout the present disclosure. Accordingly, the benefits of the present disclosure may be applied in a wide variety of processes and systems, and any such processes or systems may be considered a service herein. One of skill in the art, having the benefit of the disclosure herein and knowledge about a user interface, can readily determine the purposes and use of a user interface in various embodiments and contexts disclosed herein. Certain considerations for the person of skill in the art, in determining whether a contemplated interface is a user interface and/or whether aspects of the present disclosure can benefit or enhance the contemplated system include, without limitation: configurable views, ability to restrict manipulation or views, report functions, ability to manipulate user profile and data, implement regulatory requirements, provide the desired user features for borrowers, lenders, and 3rd parties, and the like.

Interfaces and dashboards as utilized herein may further be understood broadly to describe a component by which interaction or communication is achieved, such as a component of a computer, which may be embodied in software, hardware, or a combination thereof. Interfaces and dashboards may acquire, receive, present, or otherwise administrate an item, service, offering or other aspects of a transaction or loan. For example, interfaces and dashboards may serve a number of different purposes or be configured for different applications or contexts, such as, without limitation: an application programming interface, a graphic user interface, user interface, software interface, marketplace interface, demand aggregation interface, crowdsourcing interface, secure access control interface, network interface, data integration interface or a cloud computing interface, or combinations thereof. An interface or dashboard may serve to act as a way to receive or display data, within the context of lending, refinancing, collection, consolidation, factoring, brokering or foreclosure, without limitation. An interface or dashboard may serve as an interface or dashboard for another interface or dashboard. Without limitation to any other aspect or description of the present disclosure, an interface may be used in conjunction with applications, circuits, controllers, processes, modules, services, layers, devices, components, machines, products, sub-systems, interfaces, connections, or as part of a system. In certain embodiments, an interface or dashboard may be embodied in computer readable instructions, hardware, or a combination thereof, as well as stored on a medium or in memory. One of skill in the art, having the benefit of the disclosure herein and knowledge ordinarily available about a contemplated system, can readily determine the purposes and use of interfaces and/or dashboards in various embodiments and contexts disclosed herein.

The term domain as utilized herein may be understood broadly to describe a scope or context of a transaction and/or communications related to a transaction. For example, a domain may serve a number of different purposes or be configured for different applications or contexts, such as, without limitation: a domain for execution, a domain for a digital asset, domains to which a request will be published, domains to which social network data collection and monitoring services will be applied, domains to which Internet of Things data collection and monitoring services will be applied, network domains, geolocation domains, jurisdictional location domains, and time domains. Without limitation to any other aspect or description of the present disclosure, one or more domains may be utilized relative to any applications, circuits, controllers, processes, modules, services, layers, devices, components, machines, products, sub-systems, interfaces, connections, or as part of a system. In certain embodiments, a domain may be embodied in computer readable instructions, hardware, or a combination thereof, as well as stored on a medium or in memory. One of skill in the art, having the benefit of the disclosure herein and knowledge about a domain, can readily determine the purposes and use of a domain in various embodiments and contexts disclosed herein.

The term request (and variations) as utilized herein may be understood broadly to describe the action or instance of initiating or asking for a thing (e.g., information, a response, an object, and the like) to be provided. A specific type of request may also serve a number of different purposes or be configured for different applications or contexts, such as, without limitation: a formal legal request (e.g., a subpoena), a request to refinance (e.g., a loan), or a crowdsourcing request. Systems may be utilized to perform requests as well as fulfill requests. Requests in various forms may be included where discussing a legal action, a refinancing of a loan, or a crowdsourcing service, without limitation. One of skill in the art, having the benefit of the disclosure herein and knowledge about a contemplated system, can readily determine the value of a request implemented in an embodiment. While specific examples of requests are described herein for purposes of illustration, any embodiment benefitting from the disclosures herein, and any considerations understood to one of skill in the art having the benefit of the disclosures herein, are specifically contemplated within the scope of the present disclosure.

The term reward (and variations) as utilized herein may be understood broadly to describe a thing or consideration received or provided in response to an action or stimulus. Rewards can be of a financial type, or non-financial type, without limitation. A specific type of reward may also serve a number of different purposes or be configured for different applications or contexts, such as, without limitation: a reward event, claims for rewards, monetary rewards, rewards captured as a data set, rewards points, and other forms of rewards. Rewards may be triggered, allocated, generated for innovation, provided for the submission of evidence, requested, offered, selected, administrated, managed, configured, allocated, conveyed, identified, without limitation, as well as other actions. Systems may be utilized to perform the aforementioned actions. Rewards in various forms may be included where discussing a particular behavior, or encouragement of a particular behavior, without limitation. In certain embodiments herein, a reward may be utilized as a specific incentive (e.g., rewarding a particular person that responds to a crowdsourcing request) or as a general incentive (e.g., providing a reward responsive to a successful crowdsourcing request, in addition to or alternatively to a reward to the particular person that responded). One of skill in the art, having the benefit of the disclosure herein and knowledge about a reward, can readily determine the value of a reward implemented in an embodiment. While specific examples of rewards are described herein for purposes of illustration, any embodiment benefitting from the disclosures herein, and any considerations understood to one of skill in the art having the benefit of the disclosures herein, are specifically contemplated within the scope of the present disclosure.

The term robotic process automation system as utilized herein may be understood broadly to describe a system capable of performing tasks or providing needs for a system of the present disclosure. For example, a robotic process automation system, without limitation, can be configured for: negotiation of a set of terms and conditions for a loan, negotiation of refinancing of a loan, loan collection, consolidating a set of loans, managing a factoring loan, brokering a mortgage loan, training for foreclosure negotiations, configuring a crowdsourcing request based on a set of attributes for a loan, setting a reward, determining a set of domains to which a request will be published, configuring the content of a request, configuring a data collection and monitoring action based on a set of attributes of a loan, determining a set of domains to which the Internet of Things data collection and monitoring services will be applied, and iteratively training and improving based on a set of outcomes. A robotic process automation system may include: a set of data collection and monitoring services, an artificial intelligence system, and another robotic process automation system which is a component of the higher level robotic process automation system. The robotic process automation system may include: at least one of the set of mortgage loan activities and the set of mortgage loan interactions includes activities among marketing activity, identification of a set of prospective borrowers, identification of property, identification of collateral, qualification of borrower, title search, title verification, property assessment, property inspection, property valuation, income verification, borrower demographic analysis, identification of capital providers, determination of available interest rates, determination of available payment terms and conditions, analysis of existing mortgage, comparative analysis of existing and new mortgage terms, completion of application workflow, population of fields of application, preparation of mortgage agreement, completion of schedule to mortgage agreement, negotiation of mortgage terms and conditions with capital provider, negotiation of mortgage terms and conditions with borrower, transfer of title, placement of lien and closing of mortgage agreement. Example and non-limiting robotic process automation systems may include one or more user interfaces, interfaces with circuits and/or controllers throughout the system to provide, request, and/or share data, and/or one or more artificial intelligence circuits configured to iteratively improve one or more operations of the robotic process automation system. One of skill in the art, having the benefit of the disclosure herein and knowledge ordinarily available about a contemplated robotic process automation system, can readily determine the circuits, controllers, and/or devices to include to implement a robotic process automation system performing the selected functions for the contemplated system. While specific examples of robotic process automation systems are described herein for purposes of illustration, any embodiment benefitting from the disclosures herein, and any considerations understood.

The term loan-related action (and other related terms such as loan-related event and loan-related activity) are utilized herein and may be understood broadly to describe one or multiple actions, events or activities relating to a transaction that includes a loan within the transaction. The action, event or activity may occur in many different contexts of loans, such as lending, refinancing, consolidation, factoring, brokering, foreclosure, administration, negotiating, collecting, procuring, enforcing and data processing (e.g., data collection), or combinations thereof, without limitation. A loan-related action may be used in the form of a noun (e.g., a notice of default has been communicated to the borrower with formal notice, which could be considered a loan-related action). A loan-related action, event, or activity may refer to a single instance, or may characterize a group of actions, events, or activities. For example, a single action such as providing a specific notice to a borrower of an overdue payment may be considered a loan-related action. Similarly, a group of actions from start to finish relating to a default may also be considered a single loan-related action. Appraisal, inspection, funding, and recording, without limitation, may all also be considered loan-related actions that have occurred, as well as events relating to the loan, and may also be loan-related events. Similarly, these activities of completing these actions may also be considered loan-related activities (e.g., appraising, inspecting, funding, recording, etc.), without limitation. In certain embodiments, a smart contract or robotic process automation system may perform loan-related actions, loan-related events, or loan-related activities for one or more of the parties, and process appropriate tasks for completion of the same. In some cases the smart contract or robotic process automation system may not complete a loan-related action, and depending upon such outcome this may enable an automated action or may trigger other conditions or terms. One of skill in the art, having the benefit of the disclosure herein and knowledge about loan-related actions, events, and activities can readily determine the purposes and use of this term in various forms and embodiments as described throughout the present disclosure.

The term loan-related action, events, and activities, as noted herein, may also more specifically be utilized to describe a context for calling of a loan. A calling of a loan is an action wherein the lender can demand the loan be repaid, usually triggered by some other condition or term, such as delinquent payment(s). For example, a loan-related action for calling of the loan may occur when a borrower misses three payments in a row, such that there is a severe delinquency in the loan payment schedule, and the loan goes into default. In such a scenario, a lender may be initiating loan-related actions for calling of the loan to protect its rights. In such a scenario, perhaps the borrower pays a sum to cure the delinquency and penalties, which may also be considered as a loan-related action for calling of the loan. In some circumstances, a smart contract or robotic process automation system may initiate, administrate, or process loan-related actions for calling of the loan, which without limitation, may including providing notice, researching, and collecting payment history, or other tasks performed as a part of the calling of the loan. One of skill in the art, having the benefit of the disclosure herein and knowledge about loan-related actions for calling of the loan, or other forms of the term and its various forms, can readily determine the purposes and use of this term in the context of an event or other various embodiments and contexts disclosed herein.

The term loan-related action, events, and activities, as noted herein, may also more specifically be utilized to describe a context for payment of a loan. Typically in transactions involving loans, without limitation, a loan is repaid on a payment schedule. Various actions may be taken to provide a borrower with information to pay back the loan, as well as actions for a lender to receive payment for the loan. For example, if a borrower makes a payment on the loan, a loan-related action for payment of the loan may occur. Without limitation, such a payment may comprise several actions that may occur with respect to the payment on the loan, such as: the payment being tendered to the lender, the loan ledger or accounting reflecting that a payment has been made, a receipt provided to the borrower of the payment made, and the next payment being requested of the borrower. In some circumstances, a smart contract or robotic process automation system may initiate, administrate, or process such loan-related actions for payment of the loan, which without limitation, may including providing notice to the lender, researching and collecting payment history, providing a receipt to the borrower, providing notice of the next payment due to the borrower, or other actions associated with payment of the loan. One of skill in the art, having the benefit of the disclosure herein and knowledge about loan-related actions for payment of a loan, or other forms of the term and its various forms, can readily determine the purposes and use of this term in the context of an event or other various embodiments and contexts disclosed herein.

The term loan-related action, events, and activities, as noted herein, may also more specifically be utilized to describe a context for a payment schedule or alternative payment schedule. Typically in transactions involving loans, without limitation, a loan is repaid on a payment schedule, which may be modified over time. Or, such a payment schedule may be developed and agreed in the alternative, with an alternative payment schedule. Various actions may be taken in the context of a payment schedule or alternate payment schedule for the lender or the borrower, such as: the amount of such payments, when such payments are due, what penalties or fees may attach to late payments, or other terms. For example, if a borrower makes an early payment on the loan, a loan-related action for payment schedule and alternative payment schedule of the loan may occur; in such case, perhaps the payment is applied as principal, with the regular payment still being due. Without limitation, loan-related actions for a payment schedule and alternative payment schedule may comprise several actions that may occur with respect to the payment on the loan, such as: the payment being tendered to the lender, the loan ledger or accounting reflecting that a payment has been made, a receipt provided to the borrower of the payment made, a calculation if any fees are attached or due, and the next payment being requested of the borrower. In certain embodiments, an activity to determine a payment schedule or alternative payment schedule may be a loan-related action, event, or activity. In certain embodiments, an activity to communicate the payment schedule or alternative payment schedule (e.g., to the borrower, the lender, or a 3rd party) may be a loan-related action, event, or activity. In some circumstances, a smart contract circuit or robotic process automation system may initiate, administrate, or process such loan-related actions for payment schedule and alternative payment schedule, which without limitation, may include providing notice to the lender, researching and collecting payment history, providing a receipt to the borrower, calculating the next due date, calculating the final payment amount and date, providing notice of the next payment due to the borrower, determining the payment schedule or an alternate payment schedule, communicating the payment scheduler or an alternate payment schedule, or other actions associated with payment of the loan. One of skill in the art, having the benefit of the disclosure herein and knowledge about loan-related actions for payment schedule and alternative payment schedule, or other forms of the term and its various forms, can readily determine the purposes and use of this term in the context of an event or other various embodiments and contexts disclosed herein.

The term regulatory notice requirement (and any derivatives) as utilized herein may be understood broadly to describe an obligation or condition to communicate a notification or message to another party or entity. The regulatory notice requirement may be required under one or more conditions that are triggered, or generally required. For example, a lender may have a regulatory notice requirement to provide notice to a borrower of a default of a loan, or change of an interest rate of a loan, or other notifications relating to a transaction or loan. The regulatory aspect of the term may be attributed to jurisdiction-specific laws, rules, or codes that require certain obligations of communication. In certain embodiments, a policy directive may be treated as a regulatory notice requirement, for example where a lender has an internal notice policy that may exceed the regulatory requirements of one or more of the jurisdictional locations related to a transaction. The notice aspect generally relates to formal communications, which may take many different forms, but may specifically be specified as a particular form of notice, such as a certified mail, facsimile, email transmission, or other physical or electronic form, a content for the notice, and/or a timing requirement related to the notice. The requirement aspect relates to the necessity of a party to complete its obligation to be in compliance with laws, rules, codes, policies, standard practices, or terms of an agreement or loan. In certain embodiments, a smart contract may process or trigger regulatory notice requirements and provide appropriate notice to a borrower. This may be based on location of at least one of: the lender, the borrower, the funds provided via the loan, the repayment of the loan, and the collateral of the loan, or other locations as designated by the terms of the loan, transaction, or agreement. In cases where a party or entity has not satisfied such regulatory notice requirements, certain changes in the rights or obligations between the parties may be triggered—for example where a lender provides a non-compliant notice to the borrower, an automated action or trigger based on the terms and conditions of the loan, and/or based on external information (e.g., a regulatory prescription, internal policy of the lender, etc.) may be affected by a smart contract circuit and/or robotic process automation system may be implemented. One of skill in the art, having the benefit of the disclosure herein and knowledge ordinarily available about a contemplated system, can readily determine the purposes and use of regulatory notice requirements in various embodiments and contexts disclosed herein.

The term regulatory notice requirement may also be utilized herein to describe an obligation or condition to communicate a notification or message to another party or entity based upon a general or specific policy, rather than based on a particular jurisdiction, or laws, rules, or codes of a particular location (as in regulatory notice requirement that may be jurisdiction-specific). The regulatory notice requirement may be prudent or suggested, rather than obligatory or required, under one or more conditions that are triggered, or generally required. For example, a lender may have a regulatory notice requirement that is policy based to provide notice to a borrower of a new informational website, or will experience a change of an interest rate of a loan in the future, or other notifications relating to a transaction or loan that are advisory or helpful, rather than mandatory (although mandatory notices may also fall under a policy basis). Thus, in policy based uses of the regulatory notice requirement term, a smart contract circuit may process or trigger regulatory notice requirements and provide appropriate notice to a borrower which may or may not necessarily be required by a law, rule, or code. The basis of the notice or communication may be out of prudence, courtesy, custom, or obligation.

The term regulatory notice may also be utilized herein to describe an obligation or condition to communicate a notification or message to another party or entity specifically, such as a lender or borrower. The regulatory notice may be specifically directed toward any party or entity, or a group of parties or entities. For example, a particular notice or communication may be advisable or required to be provided to a borrower, such as on circumstances of a borrower's failure to provide scheduled payments on a loan resulting in a default. As such, such a regulatory notice directed to a particular user, such as a lender or borrower, may be as a result of a regulatory notice requirement that is jurisdiction-specific or policy-based, or otherwise. Thus, in some circumstances a smart contract may process or trigger a regulatory notice and provide appropriate notice to a specific party such as a borrower, which may or may not necessarily be required by a law, rule, or code, but may otherwise be provided out of prudence, courtesy or custom. In cases where a party or entity has not satisfied such regulatory notice requirements to a specific party or parties, it may create circumstances where certain rights may be forgiven by one or more parties or entities, or may enable automated action or trigger other conditions or terms. One of skill in the art, having the benefit of the disclosure herein and knowledge ordinarily available about a contemplated system, can readily determine the purposes and use of regulatory notice requirements based in various embodiments and contexts disclosed herein.

The term regulatory foreclosure requirement (and any derivatives) as utilized herein may be understood broadly to describe an obligation or condition in order to trigger, process or complete default of a loan, foreclosure, or recapture of collateral, or other related foreclosure actions. The regulatory foreclosure requirement may be required under one or more conditions that are triggered, or generally required. For example, a lender may have a regulatory foreclosure requirement to provide notice to a borrower of a default of a loan, or other notifications relating to the default of a loan prior to foreclosure. The regulatory aspect of the term may be attributed to jurisdiction-specific laws, rules, or codes that require certain obligations of communication. The foreclosure aspect generally relates to the specific remedy of foreclosure, or a recapture of collateral property and default of a loan, which may take many different forms, but may be specified in the terms of the loan. The requirement aspect relates to the necessity of a party to complete its obligation in order to be in compliance or performance of laws, rules, codes or terms of an agreement or loan. In certain embodiments, a smart contract circuit may process or trigger regulatory foreclosure requirements and process appropriate tasks relating to such a foreclosure action. This may be based on a jurisdictional location of at least one of the lender, the borrower, the fund provided via the loan, the repayment of the loan, and the collateral of the loan, or other locations as designated by the terms of the loan, transaction, or agreement. In cases where a party or entity has not satisfied such regulatory foreclosure requirements, certain rights may be forgiven by the party or entity (e.g., a lender), or such a failure to comply with the regulatory notice requirement may enable automated action or trigger other conditions or terms. One of skill in the art, having the benefit of the disclosure herein and knowledge ordinarily available about a contemplated system, can readily determine the purposes and use of regulatory foreclosure requirements in various embodiments and contexts disclosed herein.

The term regulatory foreclosure requirement may also be utilized herein to describe an obligation or in order to trigger, process or complete default of a loan, foreclosure, or recapture of collateral, or other related foreclosure actions. based upon a general or specific policy rather than based on a particular jurisdiction, or laws, rules, or codes of a particular location (as in regulatory foreclosure requirement that may be jurisdiction-specific). The regulatory foreclosure requirement may be prudent or suggested, rather than obligatory or required, under one or more conditions that are triggered, or generally required. For example, a lender may have a regulatory foreclosure requirement that is policy based to provide notice to a borrower of a default of a loan, or other notifications relating to a transaction or loan that are advisory or helpful, rather than mandatory (although mandatory notices may also fall under a policy basis). Thus, in policy based uses of the regulatory foreclosure requirement term, a smart contract may process or trigger regulatory foreclosure requirements and provide appropriate notice to a borrower which may or may not necessarily be required by a law, rule, or code. The basis of the notice or communication may be out of prudence, courtesy, custom, industry practice, or obligation.

The term regulatory foreclosure requirements may also be utilized herein to describe an obligation or condition that is to be performed with regard to a specific user, such as a lender or a borrower. The regulatory notice may be specifically directed toward any party or entity, or a group of parties or entities. For example, a particular notice or communication may be advisable or required to be provided to a borrower, such as on circumstances of a borrower's failure to provide scheduled payments on a loan resulting in a default. As such, such a regulatory foreclosure requirement is directed to a particular user, such as a lender or borrower, and may be a result of a regulatory foreclosure requirement that is jurisdiction-specific or policy-based, or otherwise. For example, the foreclosure requirement may be related to a specific entity involved with a transaction (e.g., the current borrower has been a customer for 30 years, so s/he receives unique treatment), or to a class of entities (e.g., “preferred” borrowers, or “first time default” borrowers). Thus, in some circumstances a smart contract circuit may process or trigger an obligation or action that must be taken pursuant to a foreclosure, where the action is directed or from a specific party such as a lender or a borrower, which may or may not necessarily be required by a law, rule, or code, but may otherwise be provided out of prudence, courtesy, or custom. In certain embodiments, the obligation or condition that is to be performed with regard to the specific user may form a part of the terms and conditions or otherwise be known to the specific user to which it applies (e.g., an insurance company or bank that advertises a specific practice with regard to a specific class of customers, such as first-time default customers, first-time accident customers, etc.), and in certain embodiments the obligation or condition that is to be performed with regard to the specific user may be unknown to the specific user to which it applies (e.g., a bank has a policy relating to a class of users to which the specific user belongs, but the specific user is not aware of the classification).

The terms value, valuation, valuation model (and similar terms) as utilized herein should be understood broadly to describe an approach to evaluate and determine the estimated value for collateral. Without limitation to any other aspect or description of the present disclosure, a valuation model may be used in conjunction with: collateral (e.g., a secured property), artificial intelligence services (e.g., to improve a valuation model), data collection and monitoring services (e.g., to set a valuation amount), valuation services (e.g., the process of informing, using, and/or improving a valuation model), and/or outcomes relating to transactions in collateral (e.g., as a basis of improving the valuation model). “Jurisdiction-specific valuation model” is also used as a valuation model used in a specific geographic/jurisdictional area or region; wherein, the jurisdiction can be specific to jurisdiction of the lender, the borrower, the delivery of funds, the payment of the loan or the collateral of the loan, or combinations thereof. In certain embodiments, a jurisdiction-specific valuation model considers jurisdictional effects on a valuation of collateral, including at least: rights and obligations for borrowers and lenders in the relevant jurisdiction(s); jurisdictional effects on the ability to move, import, export, substitute, and/or liquidate the collateral; jurisdictional effects on the timing between default and foreclosure or collection of collateral; and/or jurisdictional effects on the volatility and/or sensitivity of collateral value determinations. In certain embodiments, a geolocation-specific valuation model considers geolocation effects on a valuation of the collateral, which may include a similar list of considerations relative jurisdictional effects (although the jurisdictional location(s) may be distinct from the geolocation(s)), but may also include additional effects, such as: weather-related effects; distance of the collateral from monitoring, maintenance, or seizure services; and/or proximity of risk phenomenon (e.g., fault lines, industrial locations, a nuclear plant, etc.). A valuation model may utilize a valuation of offset collateral (e.g., a similar item of collateral, a generic value such as a market value of similar or fungible collateral, and/or a value of an item that correlates with a value of the collateral) as a part of the valuation of the collateral. In certain embodiments, an artificial intelligence circuit includes one or more machine learning and/or artificial intelligence algorithms, to improve a valuation model, including, for example, utilizing information over time between multiple transactions involving similar or offset collateral, and/or utilizing outcome information (e.g., where loan transactions are completed successfully or unsuccessfully, and/or in response to collateral seizure or liquidation events that demonstrate real-world collateral valuation determinations) from the same or other transactions to iteratively improve the valuation model. In certain embodiments, an artificial intelligence circuit is trained on a collateral valuation data set, for example previously determined valuations and/or through interactions with a trainer (e.g., a human, accounting valuations, and/or other valuation data). In certain embodiments, the valuation model and/or parameters of the valuation model (e.g., assumptions, calibration values, etc.) may be determined and/or negotiated as a part of the terms and conditions of the transaction (e.g., a loan, a set of loans, and/or a subset of the set of loans). One of skill in the art, having the benefit of the disclosure herein and knowledge ordinarily available about a contemplated system, can readily determine which aspects of the present disclosure will benefit a particular application for a valuation model, and how to choose or combine valuation models to implement an embodiment of a valuation model. Certain considerations for the person of skill in the art, or embodiments of the present disclosure in choosing an appropriate valuation model, include, without limitation: the legal considerations of a valuation model given the jurisdiction of the collateral; the data available for a given collateral; the anticipated transaction/loan type(s); the specific type of collateral; the ratio of the loan to value; the ratio of the collateral to the loan; the gross transaction/loan amount; the credit scores of the borrower; accounting practices for the loan type and/or related industry; uncertainties related to any of the foregoing; and/or sensitivities related to any of the foregoing. While specific examples of valuation models and considerations are described herein for purposes of illustration, any embodiment benefitting from the disclosures herein, and any considerations understood to one of skill in the art having the benefit of the disclosures herein, are specifically contemplated within the scope of the present disclosure

The term market value data, or marketplace information, (and other forms or variations) as utilized herein may be understood broadly to describe data or information relating to the valuation of a property, asset, collateral, or other valuable items which may be used as the subject of a loan, collateral, or transaction. Market value data or marketplace information may change from time to time, and may be estimated, calculated, or objectively or subjectively determined from various sources of information. Market value data or marketplace information may be related directly to an item of collateral or to an off-set item of collateral. Market value data or marketplace information may include financial data, market ratings, product ratings, customer data, market research to understand customer needs or preferences, competitive intelligence re. competitors, suppliers, and the like, entities sales, transactions, customer acquisition cost, customer lifetime value, brand awareness, churn rate, and the like. The term may occur in many different contexts of contracts or loans, such as lending, refinancing, consolidation, factoring, brokering, foreclosure, and data processing (e.g., data collection), or combinations thereof, without limitation. Market value data or marketplace information may be used as a noun to identify a single figure or a plurality of figures or data. For example, market value data or marketplace information may be utilized by a lender to determine if a property or asset will serve as collateral for a secured loan, or may alternatively be utilized in the determination of foreclosure if a loan is in default, without limitation to these circumstances in use of the term. Marketplace value data or marketplace information may also be used to determine loan-to-value figures or calculations. In certain embodiments, a collection service, smart contract circuit, and/or robotic process automation system may estimate or calculate market value data or marketplace information from one or more sources of data or information. In some cases market data value or marketplace information, depending upon the data/information contained therein, may enable automated action, or trigger other conditions or terms. One of skill in the art, having the benefit of the disclosure herein and knowledge ordinarily available about a contemplated system and available relevant marketplace information, can readily determine the purposes and use of this term in various forms, embodiments and contexts disclosed herein.

The terms similar collateral, similar to collateral, off-set collateral, and other forms or variations as utilized herein may be understood broadly to describe a property, asset or valuable item that may be like in nature to a collateral (e.g., an article of value held in security) regarding a loan or other transaction. Similar collateral may refer to a property, asset, collateral or other valuable item which may be aggregated, substituted, or otherwise referred to in conjunction with other collateral, whether the similarity comes in the form of a common attribute such as type of item of collateral, category of the item of collateral, an age of the item of collateral, a condition of the item of collateral, a history of the item of collateral, an ownership of the item of collateral, a caretaker of the item of collateral, a security of the item of collateral, a condition of an owner of the item of collateral, a lien on the item of collateral, a storage condition of the item of collateral, a geolocation of the item of collateral, and a jurisdictional location of the item of collateral, and the like. In certain embodiments, an offset collateral references an item that has a value correlation with an item of collateral—for example, an offset collateral may exhibit similar price movements, volatility, storage requirements, or the like for an item of collateral. In certain embodiments, similar collateral may be aggregated to form a larger security interest or collateral for an additional loan or distribution, or transaction. In certain embodiments, offset collateral may be utilized to inform a valuation of the collateral. In certain embodiments, a smart contract circuit or robotic process automation system may estimate or calculate figures, data or information relating to similar collateral, or may perform a function with respect to aggregating similar collateral. One of skill in the art, having the benefit of the disclosure herein and knowledge ordinarily available about a contemplated system can readily determine the purposes and use of similar collateral, offset collateral, or related terms as they relate to collateral in various forms, embodiments, and contexts disclosed herein.

The term restructure (and other forms such as restructuring) as utilized herein may be understood broadly to describe a modification of terms or conditions, properties, collateral, or other considerations affecting a loan or transaction. Restructuring may result in a successful outcome where amended terms or conditions are adopted between parties, or an unsuccessful outcome where no modification or restructure occurs, without limitation. Restructuring can occur in many contexts of contracts or loans, such as application, lending, refinancing, collection, consolidation, factoring, brokering, foreclosure, and combinations thereof, without limitation. Debt may also be restructured, which may indicate that debts owed to a party are modified as to timing, amounts, collateral, or other terms. For example, a borrower may restructure debt of a loan to accommodate a change of financial conditions, or a lender may offer to a borrower the restructuring of a debt for its own needs or prudence. In certain embodiments, a smart contract circuit or robotic process automation system may automatically or manually restructure debt based on a monitored condition, or create options for restructuring a debt, administrate the process of negotiating or effecting the restructuring of a debt, or other actions in connection with restructuring or modifying terms of a loan or transaction. One of skill in the art, having the benefit of the disclosure herein and knowledge ordinarily available about a contemplated system, can readily determine the purposes and use of this term, whether in the context of debt or otherwise, in various embodiments and contexts disclosed herein.

The term social network data collection, social network monitoring services, and social network data collection and monitoring services (and its various forms or derivatives) as utilized herein may be understood broadly to describe services relating to the acquisition, organizing, observing, or otherwise acting upon data or information derived from one or more social networks. The social network data collection and monitoring services may be a part of a related system of services or a standalone set of services. Social network data collection and monitoring services may be provided by a platform or system, without limitation. Social network data collection and monitoring services may be used in a variety of contexts such as lending, refinancing, negotiation, collection, consolidation, factoring, brokering, foreclosure, and combinations thereof, without limitation. Requests of social network data collection and monitoring, with configuration parameters, may be requested by other services, automatically initiated, or triggered to occur based on conditions or circumstances that occur. An interface may be provided to configure, initiate, display, or otherwise interact with social network data collection and monitoring services. Social networks, as utilized herein, reference any mass platform where data and communications occur between individuals and/or entities, where the data and communications are at least partially accessible to an embodiment system. In certain embodiments, the social network data includes publicly available (e.g., accessible without any authorization) information. In certain embodiments, the social network data includes information that is properly accessible to an embodiment system, but may include subscription access or other access to information that is not freely available to the public, but may be accessible (e.g., consistent with a privacy policy of the social network with its users). A social network may be primarily social in nature, but may additionally or alternatively include professional networks, alumni networks, industry related networks, academically oriented networks, or the like. In certain embodiments, a social network may be a crowdsourcing platform, such as a platform configured to accept queries or requests directed to users (and/or a subset of users, potentially meeting specified criteria), where users may be aware that certain communications will be shared and accessible to requestors, at least a portion of users of the platform, and/or publicly available. In certain embodiments, without limitation, social network data collection and monitoring services may be performed by a smart contract circuit or a robotic process automation system. One of skill in the art, having the benefit of the disclosure herein and knowledge ordinarily available about a contemplated system, can readily determine the purposes and use of social network data collection and monitoring services in various embodiments and contexts disclosed herein.

The term crowdsource and social network information as utilized herein may further be understood broadly to describe information acquired or provided in conjunction with a crowdsourcing model or transaction, or information acquired or provided on or in conjunction with a social network. Crowdsource and social network information may be provided by a platform or system, without limitation. Crowdsource and social network information may be acquired, provided, or communicated to or from a group of information suppliers and by which responses to the request may be collected and processed. Crowdsource and social network information may provide information, conditions or factors relating to a loan or agreement. Crowdsource and social network information may be private or published, or combinations thereof, without limitation. In certain embodiments, without limitation, crowdsource and social network information may be acquired, provided, organized, or processed, without limitation, by a smart contract circuit, wherein the crowdsource and social network information may be managed by a smart contract circuit that processes the information to satisfy a set of configured parameters. One of skill in the art, having the benefit of the disclosure herein and knowledge ordinarily available about a contemplated system can readily determine the purposes and use of this term in various embodiments and contexts disclosed herein.

The term negotiate (and other forms such as negotiating or negotiation) as utilized herein may be understood broadly to describe discussions or communications to bring about or obtain a compromise, outcome, or agreement between parties or entities. Negotiation may result in a successful outcome where terms are agreed between parties, or an unsuccessful outcome where the parties do not agree to specific terms, or combinations thereof, without limitation. A negotiation may be successful in one aspect or for a particular purpose, and unsuccessful in another aspect or for another purpose. Negotiation can occur in many contexts of contracts or loans, such as lending, refinancing, collection, consolidation, factoring, brokering, foreclosure, and combinations thereof, without limitation. For example, a borrower may negotiate an interest rate or loan terms with a lender. In another example, a borrower in default may negotiate an alternative resolution to avoid foreclosure with a lender. In certain embodiments, a smart contract circuit or robotic process automation system may negotiate for one or more of the parties, and process appropriate tasks for completing or attempting to complete a negotiation of terms. In some cases negotiation by the smart contract or robotic process automation system may not complete or be successful. Successful negotiation may enable automated action or trigger other conditions or terms to be implemented by the smart contract circuit or robotic process automation system. One of skill in the art, having the benefit of the disclosure herein and knowledge ordinarily available about a contemplated system, can readily determine the purposes and use of negotiation in various embodiments and contexts disclosed herein.

The term negotiate in various forms may more specifically be utilized herein in verb form (e.g., to negotiate) or in noun forms (e.g., a negotiation), or other forms to describe a context of mutual discussion leading to an outcome. For example, a robotic process automation system may negotiate terms and conditions on behalf of a party, which would be a use as a verb clause. In another example, a robotic process automation system may be negotiating terms and conditions for modification of a loan, or negotiating a consolidation offer, or other terms. As a noun clause, a negotiation (e.g., an event) may be performed by a robotic process automation system. Thus, in some circumstances a smart contract circuit or robotic process automation system may negotiate (e.g., as a verb clause) terms and conditions, or the description of doing so may be considered a negotiation (e.g., as a noun clause). One of skill in the art, having the benefit of the disclosure herein and knowledge about negotiating and negotiation, or other forms of the word negotiate, can readily determine the purposes and use of this term in various embodiments and contexts disclosed herein.

The term negotiate in various forms may also specifically be utilized to describe an outcome, such as a mutual compromise or completion of negotiation leading to an outcome. For example, a loan may, by robotic process automation system or otherwise, be considered negotiated as a successful outcome that has resulted in an agreement between parties, where the negotiation has reached completion. Thus, in some circumstances a smart contract circuit or robotic process automation system may have negotiated to completion a set of terms and conditions, or a negotiated loan. One of skill in the art, having the benefit of the disclosure herein and knowledge ordinarily available for a contemplated system, can readily determine the purposes and use of this term as it relates to a mutually agreed outcome through completion of negotiation in various embodiments and contexts disclosed herein.

The term negotiate in various forms may also specifically be utilized to characterize an event such as a negotiating event, or an event negotiation, including reaching a set of agreeable terms between parties. An event requiring mutual agreement or compromise between parties may be considered a negotiating event, without limitation. For example, during the procurement of a loan, the process of reaching a mutually acceptable set of terms and conditions between parties could be considered a negotiating event. Thus, in some circumstances a smart contract circuit or robotic process automation system may accommodate the communications, actions, or behaviors of the parties for a negotiated event.

The term collection (and other forms such as collect or collecting) as utilized herein may be understood broadly to describe the acquisition of a tangible (e.g., physical item), intangible (e.g., data, a license, or a right), or monetary (e.g., payment) item, or other obligation or asset from a source. The term generally may relate to the entire prospective acquisition of such an item from related tasks in early stages to related tasks in late stages or full completion of the acquisition of the item. Collection may result in a successful outcome where the item is tendered to a party, or may or an unsuccessful outcome where the item is not tendered or acquired to a party, or combinations thereof (e.g., a late or otherwise deficient tender of the item), without limitation. Collection may occur in many different contexts of contracts or loans, such as lending, refinancing, consolidation, factoring, brokering, foreclosure, and data processing (e.g., data collection), or combinations thereof, without limitation. Collection may be used in the form of a noun (e.g., data collection or the collection of an overdue payment where it refers to an event or characterizes an event), may refer as a noun to an assortment of items (e.g., a collection of collateral for a loan where it refers to a number of items in a transaction), or may be used in the form of a verb (e.g., collecting a payment from the borrower). For example, a lender may collect an overdue payment from a borrower through an online payment, or may have a successful collection of overdue payments acquired through a customer service telephone call. In certain embodiments, a smart contract circuit or robotic process automation system may perform collection for one or more of the parties, and process appropriate tasks for completing or attempting collection for one or more items (e.g., an overdue payment). In some cases negotiation by the smart contract or robotic process automation system may not complete or be successful, and depending upon such outcomes this may enable automated action or trigger other conditions or terms. One of skill in the art, having the benefit of the disclosure herein and knowledge ordinarily available about a contemplated system, can readily determine the purposes and use of collection in various forms, embodiments, and contexts disclosed herein.

The term collection in various forms may also more specifically be utilized herein in noun form to describe a context for an event or thing, such as a collection event, or a collection payment. For example, a collection event may refer to a communication to a party or other activity that relates to acquisition of an item in such an activity, without limitation. A collection payment, for example, may relate to a payment made by a borrower that has been acquired through the process of collection, or through a collection department with a lender. Although not limited to an overdue, delinquent, or defaulted loan, collection may characterize an event, payment or department, or other noun associated with a transaction or loan, as being a remedy for something that has become overdue. Thus, in some circumstances a smart contract circuit or robotic process automation system may collect a payment or installment from a borrower, and the activity of doing so may be considered a collection event, without limitation.

The term collection in various forms may also more specifically be utilized herein as an adjective or other forms to describe a context relating to litigation, such as the outcome of a collection litigation (e.g., litigation regarding overdue or default payments on a loan). For example, the outcome of a collection litigation may be related to delinquent payments which are owed by a borrower or other party, and collection efforts relating to those delinquent payments may be litigated by parties. Thus, in some circumstances a smart contract circuit or robotic process automation system may receive, determine, or otherwise administrate the outcome of collection litigation.

The term collection in various forms may also more specifically be utilized herein as an adjective or other forms to describe a context relating to an action of acquisition, such as a collection action (e.g., actions to induce tendering or acquisition of overdue or default payments on a loan or other obligation). The terms collection yield, financial yield of collection, and/or collection financial yield may be used. The result of such a collection action may or may not have a financial yield. For example, a collection action may result in the payment of one or more outstanding payments on a loan, which may render a financial yield to another party such as the lender. Thus, in some circumstances a smart contract circuit or robotic process automation system may render a financial yield from a collection action, or otherwise administrate or in some manner assist in a financial yield of a collection action. In embodiments, a collection action may include the need for collection litigation.

The term collection in various forms (collection ROI, ROI on collection, ROI on collection activity, collection activity ROI, and the like) may also more specifically be utilized herein to describe a context relating to an action of receiving value, such as a collection action (e.g., actions to induce tendering or acquisition of overdue or default payments on a loan or other obligation), wherein there is a return on investment (ROI). The result of such a collection action may or may not have an ROI, either with respect to the collection action itself (as an ROI on the collection action) or as an ROI on the broader loan or transaction that is the subject of the collection action. For example, an ROI on a collection action may be prudent or not with respect to a default loan, without limitation, depending upon whether the ROI will be provided to a party such as the lender. A projected ROI on collection may be estimated, or may also be calculated given real events that transpire. In some circumstances, a smart contract circuit or robotic process automation system may render an estimated ROI for a collection action or collection event, or may calculate an ROI for actual events transpiring in a collection action or collection event, without limitation. In embodiments, such a ROI may be a positive or negative figure, whether estimated or actual.

The term reputation, measure of reputation, lender reputation, borrower reputation, entity reputation, and the like may include general, widely held beliefs, opinions, and/or perceptions that are generally held about an individual, entity, collateral, and the like. A measure for reputation may be determined based on social data including likes/dislikes, review of entity or products and services provided by the entity, rankings of the company or product, current and historic market and financial data include price, forecast, buy/sell recommendations, financial news regarding entity, competitors, and partners. Reputations may be cumulative in that a product reputation and the reputation of a company leader or lead scientist may influence the overall reputation of the entity. Reputation of an institute associated with an entity (e.g., a school being attended by a student) may influence the reputation of the entity. In some circumstances, a smart contract circuit or robotic process automation system may collect, or initiate collection of data related to the above and determine a measure or ranking of reputation. A measure or ranking of an entity's reputation may be used by a smart contract circuit or robotic process automation system in determining whether to enter into an agreement with the entity, determination of terms and conditions of a loan, interest rates, and the like. In certain embodiments, indicia of a reputation determination may be related to outcomes of one or more transactions (e.g., a comparison of “likes” on a particular social media data set to an outcome index, such as successful payments, successful negotiation outcomes, ability to liquidate a particular type of collateral, etc.) to determine the measure or ranking of an entity's reputation. One of skill in the art, having the benefit of the disclosure herein and knowledge ordinarily available about a contemplated system, can readily determine the purposes and use of the reputation, a measure or ranking of the reputation, and/or utilization of the reputation in negotiations, determination of terms and conditions, determination of whether to proceed with a transaction, and other various embodiments and contexts disclosed herein.

The term collection in various forms (e.g., collector) may also more specifically be utilized herein to describe a party or entity that induces, administrates, or facilitates a collection action, collection event, or other collection related context. The measure of reputation of a party involved, such as a collector, or during the context of a collection, may be estimated or calculated using objective, subjective, or historical metrics or data. For example, a collector may be involved in a collection action, and the reputation of that collector may be used to determine decisions, actions, or conditions. Similarly, a collection may be also used to describe objective, subjective or historical metrics or data to measure the reputation of a party involved, such as a lender, borrower, or debtor. In some circumstances, a smart contract circuit or robotic process automation system may render a collection or measures, or implement a collector, within the context of a transaction or loan.

The term collection and data collection in various forms, including data collection systems, may also more specifically be utilized herein to describe a context relating to the acquisition, organization, or processing of data, or combinations thereof, without limitation. The result of such a data collection may be related or wholly unrelated to a collection of items (e.g., grouping of the items, either physically or logically), or actions taken for delinquent payments (e.g., collection of collateral, a debt, or the like), without limitation. For example, a data collection may be performed by a data collection system, wherein data is acquired, organized, or processed for decision-making, monitoring, or other purposes of prospective or actual transaction or loan. In some circumstances, a smart contract or robotic process automation system may incorporate data collection or a data collection system, to perform portions or entire tasks of data collection, without limitation. One of skill in the art, having the benefit of the disclosure herein and knowledge ordinarily available for a contemplated system, can readily determine and distinguish the purposes and use of collection in the context of data or information as used herein.

The terms refinance, refinancing activity (ies), refinancing interactions, refinancing outcomes, and similar terms, as utilized herein should be understood broadly. Without limitation to any other aspect or description of the present disclosure refinance and refinancing activities include replacing an existing mortgage, loan, bond, debt transaction, or the like with a new mortgage, loan, bond, or debt transaction that pays off or ends the previous financial arrangement. In certain embodiments, any change to terms and conditions of a loan, and/or any material change to terms and conditions of a loan, may be considered a refinancing activity. In certain embodiments, a refinancing activity is considered only those changes to a loan agreement that result in a different financial outcome for the loan agreement. Typically, the new loan should be advantageous to the borrower or issuer, and/or mutually agreeable (e.g., improving a raw financial outcome of one, and a security or other outcome for the other). Refinancing may be done to reduce interest rates, lower regular payments, change the loan term, change the collateral associated with the loan, consolidate debt into a single loan, restructure debt, change a type of loan (e.g., variable rate to fixed rate), pay off a loan that is due, in response to an improved credit score, to enlarge the loan, and/or in response to a change in market conditions (e.g., interest rates, value of collateral, and the like).

Refinancing activity may include initiating an offer to refinance, initiating a request to refinance, configuring a refinancing interest rate, configuring a refinancing payment schedule, configuring a refinancing balance in a response to the amount or terms of the refinanced loan, configuring collateral for a refinancing including changes in collateral used, changes in terms and conditions for the collateral, a change in the amount of collateral and the like, managing use of proceeds of a refinancing, removing or placing a lien on different items of collateral as appropriate given changes in terms and conditions as part of a refinancing, verifying title for a new or existing item of collateral to be used to secure the refinanced loan, managing an inspection process title for a new or existing item of collateral to be used to secure the refinanced loan, populating an application to refinance a loan, negotiating terms and conditions for a refinanced loan and closing a refinancing. Refinance and refinancing activities may be disclosed in the context of data collection and monitoring services that collect a training set of interactions between entities for a set of loan refinancing activities. Refinance and refinancing activities may be disclosed in the context of an artificial intelligence system that is trained using the collected training set of interactions that includes both refinancing activities and outcomes. The trained artificial intelligence may then be used to recommend a refinance activity, evaluate a refinance activity, make a prediction around an expected outcome of refinancing activity, and the like. Refinance and refinancing activities may be disclosed in the context of smart contract systems which may automate a subset of the interactions and activities of refinancing. In an example, a smart contract system may automatically adjust an interest rate for a loan based on information collected via at least one of an Internet of Things system, a crowdsourcing system, a set of social network analytic services and a set of data collection and monitoring services. The interest rate may be adjusted based on rules, thresholds, model parameters that determine, or recommend, an interest rate for refinancing a loan based on interest rates available to the lender from secondary lenders, risk factors of the borrower (including predicted risk based on one or more predictive models using artificial intelligence), marketing factors (such as competing interest rates offered by other lenders), and the like. Outcomes and events of a refinancing activity may be recorded in a distributed ledger. Based on the outcome of a refinance activity, a smart contract for the refinance loan may be automatically reconfigured to define the terms and conditions for the new loan such as a principal amount of debt, a balance of debt, a fixed interest rate, a variable interest rate, a payment amount, a payment schedule, a balloon payment schedule, a specification of collateral, a specification of substitutability of collateral, a party, a guarantee, a guarantor, a security, a personal guarantee, a lien, a duration, a covenant, a foreclose condition, a default condition, and a consequence of default.

One of skill in the art, having the benefit of the disclosure herein and knowledge ordinarily available about a contemplated system can readily determine which aspects of the present disclosure will benefit from a particular application of a refinance activity, how to choose or combine refinance activities, how to implement systems, services, or circuits to automatically perform of one or more (or all) aspects of a refinance activity, and the like. Certain considerations for the person of skill in the art, or embodiments of the present disclosure in choosing an appropriate training sets of interactions with which to train an artificial intelligence to take action, recommend or predict the outcome of certain refinance activities. While specific examples of refinance and refinancing activities are described herein for purposes of illustration, any embodiment benefitting from the disclosures herein, and any considerations understood to one of skill in the art having the benefit of the disclosures herein, are specifically contemplated within the scope of the present disclosure.

The terms consolidate, consolidation activity (ies), loan consolidation, debt consolidation, consolidation plan, and similar terms, as utilized herein should be understood broadly. Without limitation to any other aspect or description of the present disclosure consolidate, consolidation activity (ies), loan consolidation, debt consolidation, or consolidation plan are related to the use of a single large loan to pay off several smaller loans, and/or the use of one or more of a set of loans to pay off at least a portion of one or more of a second set of loans. In embodiments, loan consolidation may be secured (i.e., backed by collateral) or unsecured. Loans may be consolidated to obtain a lower interest rate than one or more of the current loans, to reduce total monthly loan payments, and/or to bring a debtor into compliance on the consolidated loans or other debt obligations of the debtor. Loans that may be classified as candidates for consolidation may be determined based on a model that processes attributes of entities involved in the set of loans including identity of a party, interest rate, payment balance, payment terms, payment schedule, type of loan, type of collateral, financial condition of party, payment status, condition of collateral, and value of collateral. Consolidation activities may include managing at least one of identification of loans from a set of candidate loans, preparation of a consolidation offer, preparation of a consolidation plan, preparation of content communicating a consolidation offer, scheduling a consolidation offer, communicating a consolidation offer, negotiating a modification of a consolidation offer, preparing a consolidation agreement, executing a consolidation agreement, modifying collateral for a set of loans, handling an application workflow for consolidation, managing an inspection, managing an assessment, setting an interest rate, deferring a payment requirement, setting a payment schedule, and closing a consolidation agreement. In embodiments, there may be systems, circuits, and/or services configured to create, configure (such as using one or more templates or libraries), modify, set, or otherwise handle (such as in a user interface) various rules, thresholds, conditional procedures, workflows, model parameters, and the like to determine, or recommend, a consolidation action or plan for a lending transaction or a set of loans based on one or more events, conditions, states, actions, or the like. In embodiments, a consolidation plan may be based on various factors, such as the status of payments, interest rates of the set of loans, prevailing interest rates in a platform marketplace or external marketplace, the status of the borrowers of a set of loans, the status of collateral or assets, risk factors of the borrower, the lender, one or more guarantors, market risk factors and the like. Consolidation and consolidation activities may be disclosed in the context of data collection and monitoring services that collect a training set of interactions between entities for a set of loan consolidation activities. consolidation and consolidation activities may be disclosed in the context of an artificial intelligence system that is trained using the collected training set of interactions that includes both consolidation activities and outcomes associated with those activities. The trained artificial intelligence may then be used to recommend a consolidation activity, evaluate a consolidation activity, make a prediction around an expected outcome of consolidation activity, and the like based models including status of debt, condition of collateral or assets used to secure or back a set of loans, the state of a business or business operation (e.g., receivables, payables, or the like), conditions of parties (such as net worth, wealth, debt, location, and other conditions), behaviors of parties (such as behaviors indicating preferences, behaviors indicating debt preferences), and others. Debt consolidation, loan consolidation and associated consolidation activities may be disclosed in the context of smart contract systems which may automate a subset of the interactions and activities of consolidation. In embodiments, consolidation may include consolidation with respect to terms and conditions of sets of loans, selection of appropriate loans, configuration of payment terms for consolidated loans, configuration of payoff plans for pre-existing loans, communications to encourage consolidation, and the like. In embodiments, the artificial intelligence of a smart contract may automatically recommend or set rules, thresholds, actions, parameters and the like (optionally by learning to do so based on a training set of outcomes over time), resulting in a recommended consolidation plan, which may specify a series of actions required to accomplish a recommended or desired outcome of consolidation (such as within a range of acceptable outcomes), which may be automated and may involve conditional execution of steps based on monitored conditions and/or smart contract terms, which may be created, configured, and/or accounted for by the consolidation plan. Consolidation plans may be determined and executed based at least one part on market factors (such as competing interest rates offered by other lenders, values of collateral, and the like) as well as regulatory and/or compliance factors. Consolidation plans may be generated and/or executed for creation of new consolidated loans, for secondary loans related to consolidated loans, for modifications of existing loans related to consolidation, for refinancing terms of a consolidated loan, for foreclosure situations (e.g., changing from secured loan rates to unsecured loan rates), for bankruptcy or insolvency situations, for situations involving market changes (e.g., changes in prevailing interest rates) and others. consolidation.

Certain of the activities related to loans, collateral, entities, and the like may apply to a wide variety of loans and may not apply explicitly to consolidation activities. The categorization of the activities as consolidation activities may be based on the context of the loan for which the activities are taking place. However, one of skill in the art, having the benefit of the disclosure herein and knowledge ordinarily available about a contemplated system can readily determine which aspects of the present disclosure will benefit from a particular application of a consolidation activity, how to choose or combine consolidation activities, how to implement selected services, circuits, and/or systems described herein to perform certain loan consolidation operations, and the like. While specific examples of consolidation and consolidation activities are described herein for purposes of illustration, any embodiment benefitting from the disclosures herein, and any considerations understood to one of skill in the art having the benefit of the disclosures herein, are specifically contemplated within the scope of the present disclosure.

The terms factoring a loan, factoring a loan transaction, factors, factoring a loan interaction, factoring assets or sets of assets used for factoring and similar terms, as utilized herein should be understood broadly. Without limitation to any other aspect or description of the present disclosure factoring may be applied to factoring assets such as invoices, inventory, accounts receivable, and the like, where the realized value of the item is in the future. For example, the accounts receivable is worth more when it has been paid and there is less risk of default. Inventory and Work in Progress (WIP) may be worth more as final product rather than components. References to accounts receivable should be understood to encompass these terms and not be limiting. Factoring may include a sale of accounts receivable at a discounted rate for value in the present (often cash). Factoring may also include the use of accounts receivable as collateral for a short term loan. In both cases the value of the accounts receivable or invoices may be discounted for multiple reasons including the future value of money, a term of the accounts receivable (e.g., 30 day net payment vs. 90 day net payment), a degree of default risk on the accounts receivable, a status of receivables, a status of work-in-progress (WIP), a status of inventory, a status of delivery and/or shipment, financial condition(s) of parties owing against the accounts receivable, a status of shipped and/or billed, a status of payments, a status of the borrower, a status of inventory, a risk factor of a borrower, a lender, one or more guarantors, market risk factors, a status of debt (are there other liens present on the accounts receivable or payment owed on the inventory, a condition of collateral assets (e.g., the condition of the inventory, is it current or out of date, are invoices in arrears), a state of a business or business operation, a condition of a party to the transaction (such as net worth, wealth, debt, location, and other conditions), a behavior of a party to the transaction (such as behaviors indicating preferences, behaviors indicating negotiation styles, and the like), current interest rates, any current regulatory and compliance issues associated with the inventory or accounts receivable (e.g., if inventory is being factored, has the intended product received appropriate approvals), and there legal actions against the borrower, and many others, including predicted risk based on one or more predictive models using artificial intelligence). A factor is an individual, business, entity, or groups thereof which agree to provide value in exchange for either the outright acquisition of the invoices in a sale or the use of the invoices as collateral for a loan for the value. Factoring a loan may include the identification of candidates (both lenders and borrowers) for factoring, a plan for factoring specifying the proposed receivables (e.g., all, some, only those meeting certain criteria), and a proposed discount factor, communication of the plan to potential parties, proffering an offer and receiving an offer, verification of quality of receivables, conditions regarding treatment of the receivables for the term of the loan. While specific examples of factoring and factoring activities are described herein for purposes of illustration, any embodiment benefitting from the disclosures herein, and any considerations understood to one of skill in the art having the benefit of the disclosures herein, are specifically contemplated within the scope of the present disclosure.

The terms mortgage, brokering a mortgage, mortgage collateral, mortgage loan activities, and/or mortgage related activities as utilized herein should be understood broadly. Without limitation to any other aspect or description of the present disclosure, a mortgage is an interaction where a borrower provides the title or a lien on the title of an item of value, typically property, to a lender as security in exchange for money or another item of value, to be repaid, typically with interest, to the lender. The exchange includes the condition that, upon repayment of the loan, the title reverts to the borrower and/or the lien on the property is removed. The brokering of a mortgage may include the identification of potential properties, lenders, and other parties to the loan, and arranging or negotiating the terms of the mortgage. Certain components or activities may not be considered mortgage related individually, but may be considered mortgage related when used in conjunction with a mortgage, act upon a mortgage, are related to an entity or party to a mortgage, and the like. For example, brokering may apply to the offering of a variety of loans including unsecured loans, outright sale of property and the like. Mortgage activities and mortgage interactions may include mortgage marketing activity, identification of a set of prospective borrowers, identification of property to mortgage, identification of collateral property to mortgage, qualification of borrower, title search and/or title verification for prospective mortgage property, property assessment, property inspection, or property valuation for prospective mortgage property, income verification, borrower demographic analysis, identification of capital providers, determination of available interest rates, determination of available payment terms and conditions, analysis of existing mortgage(s), comparative analysis of existing and new mortgage terms, completion of application workflow (e.g., keep the application moving forward by initiating next steps in the process as appropriate), population of fields of application, preparation of mortgage agreement, completion of schedule for mortgage agreement, negotiation of mortgage terms and conditions with capital provider, negotiation of mortgage terms and conditions with borrower, transfer of title, placement of lien on mortgaged property and closing of mortgage agreement, and similar terms, as utilized herein should be understood broadly. While specific examples of mortgages and mortgage brokering are described herein for purposes of illustration, any embodiment benefitting from the disclosures herein, and any considerations understood to one of skill in the art having the benefit of the disclosures herein, are specifically contemplated within the scope of the present disclosure.

The terms debt management, debt transactions, debt actions, debt terms and conditions, syndicating debt, consolidating debt, and/or debt portfolios, as utilized herein should be understood broadly. Without limitation to any other aspect or description of the present disclosure a debt includes something of monetary value that is owed to another. A loan typically results in the borrower holding the debt (e.g., the money that must be paid back according to the terms of the loan, which may include interest). Consolidation of debt includes the use of a new, single loan to pay back multiple loans (or various other configurations of debt structuring as described herein, and as understood to one of skill in the art). Often the new loan may have better terms or lower interest rates. Debt portfolios include a number of pieces or groups of debt, often having different characteristics including term, risk, and the like. Debt portfolio management may involve decisions regarding the quantity and quality of the debt being held and how best to balance the various debts to achieve a desired risk/reward position based on: investment policy, return on risk determinations for individual pieces of debt, or groups of debt. Debt may be syndicated where multiple lenders fund a single loan (or set of loans) to a borrower. Debt portfolios may be sold to a third party (e.g., at a discounted rate). Debt compliance includes the various measures taken to ensure that debt is repaid. Demonstrating compliance may include documentation of the actions taken to repay the debt.

Transactions related to a debt (debt transactions) and actions related to the debt (debt actions) may include offering a debt transaction, underwriting a debt transaction, setting an interest rate, deferring a payment requirement, modifying an interest rate, validating title, managing inspection, recording a change in title, assessing the value of an asset, calling a loan, closing a transaction, setting terms and conditions for a transaction, providing notices required to be provided, foreclosing on a set of assets, modifying terms and conditions, setting a rating for an entity, syndicating debt, and/or consolidating debt. Debt terms and conditions may include a balance of debt, a principal amount of debt, a fixed interest rate, a variable interest rate, a payment amount, a payment schedule, a balloon payment schedule, a specification of assets that back the bond, a specification of substitutability of assets, a party, an issuer, a purchaser, a guarantee, a guarantor, a security, a personal guarantee, a lien, a duration, a covenant, a foreclose condition, a default condition, and a consequence of default. While specific examples of debt management and debt management activities are described herein for purposes of illustration, any embodiment benefitting from the disclosures herein, and any considerations understood to one of skill in the art having the benefit of the disclosures herein, are specifically contemplated within the scope of the present disclosure.

The terms condition, condition classification, classification models, condition management, and similar terms, as utilized herein should be understood broadly. Without limitation to any other aspect or description of the present disclosure condition, condition classification, classification models, condition management, include classifying or determining a condition of an asset, issuer, borrower, loan, debt, bond, regulatory status, term or condition for a bond, loan or debt transaction that is specified and monitored in the contract, and the like. Based on a classified condition of an asset, condition management may include actions to maintain or improve a condition of the asset or the use of that asset as collateral. Based on a classified condition of an issuer, borrower, party regulatory status, and the like, condition management may include actions to alter the terms or conditions of a loan or bond. Condition classification may include various rules, thresholds, conditional procedures, workflows, model parameters, and the like to classify a condition of an asset, issuer, borrower, loan, debt, bond, regulatory status, term or condition for a bond, loan or debt transaction, and the like based on data from Internet of Things devices, data from a set of environmental condition sensors, data from a set of social network analytic services and a set of algorithms for querying network domains, social media data, crowdsourced data, and the like. Condition classification may include grouping or labeling entities, or clustering the entities, as similarly positioned with regard to some aspect of the classified condition (e.g., a risk, quality, ROI, likelihood for recovery, likelihood to default, or some other aspect of the related debt).

Various classification models are disclosed where the classification and classification model may be tied to a geographic location relating to the collateral, the issuer, the borrower, the distribution of the funds or other geographic locations. Classification and classification models are disclosed where artificial intelligence is used to improve a classification model (e.g., refine a model by making refinements using artificial intelligence data). Thus artificial intelligence may be considered, in some instances, as a part of a classification model and vice versa. Classification and classification models are disclosed where social media data, crowdsourced data, or IoT data is used as input for refining a model, or as input to a classification model. Examples of IoT data may include images, sensor data, location data, and the like. Examples of social media data or crowdsourced data may include behavior of parties to the loan, financial condition of parties, adherence to a parties to a term or condition of the loan, or bond, or the like. Parties to the loan may include issuers of a bond, related entities, lender, borrower, 3rd parties with an interest in the debt. Condition management may be discussed in connection with smart contract services which may include condition classification, data collection and monitoring, and bond, loan, and debt transaction management. Data collection and monitoring services are also discussed in conjunction with classification and classification models which are related when classifying an issuer of a bond issuer, an asset or collateral asset related to the bond, collateral assets backing the bond, parties to the bond, and sets of the same. In some embodiments a classification model may be included when discussing bond types. Specific steps, factors or refinements may be considered a part of a classification model. In various embodiments, the classification model may change both in an embodiment, or in the same embodiment which is tied to a specific jurisdiction. Different classification models may use different data sets (e.g., based on the issuer, the borrower, the collateral assets, the bond type, the loan type, and the like) and multiple classification models may be used in a single classification. For example, one type of bond, such as a municipal bond, may allow a classification model that is based on bond data from municipalities of similar size and economic prosperity, whereas another classification model may emphasize data from IoT sensors associated with a collateral asset. Accordingly, different classification models will offer benefits or risks over other classification models, depending upon the embodiment and the specifics of the bond, loan, or debt transaction. A classification model includes an approach or concept for classification. Conditions classified for a bond, loan, or debt transaction may include a principal amount of debt, a balance of debt, a fixed interest rate, a variable interest rate, a payment amount, a payment schedule, a balloon payment schedule, a specification of assets that back the bond, loan or debt transaction, a specification of substitutability of assets, a party, an issuer, a purchaser, a guarantee, a guarantor, a security, a personal guarantee, a lien, a duration, a covenant, a foreclose condition, a default condition, and/or a consequence of default. Conditions classified may include type of bond issuer such as a municipality, a corporation, a contractor, a government entity, a non-governmental entity, and a non-profit entity. Entities may include a set of issuers, a set of bonds, a set of parties, and/or a set of assets. Conditions classified may include an entity condition such as net worth, wealth, debt, location, and other conditions), behaviors of parties (such as behaviors indicating preferences, behaviors indicating debt preferences), and the like. Conditions classified may include an asset or type of collateral such as a municipal asset, a vehicle, a ship, a plane, a building, a home, real estate property, undeveloped land, a farm, a crop, a municipal facility, a warehouse, a set of inventory, a commodity, a security, a currency, a token of value, a ticket, a cryptocurrency, a consumable item, an edible item, a beverage, a precious metal, an item of jewelry, a gemstone, an item of intellectual property, an intellectual property right, a contractual right, an antique, a fixture, an item of furniture, an item of equipment, a tool, an item of machinery, and an item of personal property. Conditions classified may include a bond type where bond type may include a municipal bond, a government bond, a treasury bond, an asset-backed bond, and a corporate bond. Conditions classified may include a default condition, a foreclosure condition, a condition indicating violation of a covenant, a financial risk condition, a behavioral risk condition, a policy risk condition, a financial health condition, a physical defect condition, a physical health condition, an entity risk condition, and an entity health condition. Conditions classified may include an environment where environment may include an environment selected from among a municipal environment, a corporate environment, a securities trading environment, a real property environment, a commercial facility, a warehousing facility, a transportation environment, a manufacturing environment, a storage environment, a home, and a vehicle. Actions based on the condition of an asset, issuer, borrower, loan, debt, bond, regulatory status and the like, may include managing, reporting on, syndicating, consolidating, or otherwise handling a set of bonds (such as municipal bonds, corporate bonds, performance bonds, and others), a set of loans (subsidized and unsubsidized, debt transactions and the like, monitoring, classifying, predicting, or otherwise handling the reliability, quality, status, health condition, financial condition, physical condition or other information about a guarantee, a guarantor, a set of collateral supporting a guarantee, a set of assets backing a guarantee, or the like. Bond transaction activities in response to a condition of the bond may include offering a debt transaction, underwriting a debt transaction, setting an interest rate, deferring a payment requirement, modifying an interest rate, validating title, managing inspection, recording a change in title, assessing the value of an asset, calling a loan, closing a transaction, setting terms and conditions for a transaction, providing notices required to be provided, foreclosing on a set of assets, modifying terms and conditions, setting a rating for an entity, syndicating debt, and/or consolidating debt.

One of skill in the art, having the benefit of the disclosure herein and knowledge ordinarily available about a contemplated system, can readily determine which aspects of the present disclosure will benefit a particular application for a classification model, how to choose or combine classification models to arrive at a condition, and/or calculate a value of collateral given the required data. Certain considerations for the person of skill in the art, or embodiments of the present disclosure in choosing an appropriate condition to manage, include, without limitation: the legality of the condition given the jurisdiction of the transaction, the data available for a given collateral, the anticipated transaction type (loan, bond or debt), the specific type of collateral, the ratio of the loan to value, the ratio of the collateral to the loan, the gross transaction/loan amount, the credit scores of the borrower and the lender, and other considerations. While specific examples of conditions, condition classification, classification models, and condition management are described herein for purposes of illustration, any embodiment benefitting from the disclosures herein, and any considerations understood to one of skill in the art having the benefit of the disclosures herein, are specifically contemplated within the scope of the present disclosure.

The terms classify, classifying, classification, categorization, categorizing, categorize (and similar terms) as utilized herein should be understood broadly. Without limitation to any other aspect or description of the present disclosure, classifying a condition or item may include actions to sort the condition or item into a group or category based on some aspect, attribute, or characteristic of the condition or item where the condition or item is common or similar for all the items placed in that classification, despite divergent classifications or categories based on other aspects or conditions at the time. Classification may include recognition of one or more parameters, features, characteristics, or phenomena associated with a condition or parameter of an item, entity, person, process, item, financial construct, or the like. Conditions classified by a condition classifying system may include a default condition, a foreclosure condition, a condition indicating violation of a covenant, a financial risk condition, a behavioral risk condition, a contractual performance condition, a policy risk condition, a financial health condition, a physical defect condition, a physical health condition, an entity risk condition, and/or an entity health condition. A classification model may automatically classify or categorize items, entities, process, items, financial constructs or the like based on data received from a variety of sources. The classification model may classify items based on a single attribute or a combination of attributes, and/or may utilize data regarding the items to be classified and a model. The classification model may classify individual items, entities, financial constructs, or groups of the same. A bond may be classified based on the type of bond (e.g., municipal bonds, corporate bonds, performance bonds, and the like), rate of return, bond rating (3rd party indicator of bond quality with respect to bond issuer's financial strength, and/or ability to bap bond's principal and interest, and the like. Lenders or bond issuers may be classified based on the type of lender or issuer, permitted attributes (e.g., based on income, wealth, location (domestic or foreign), various risk factors, status of issuers, and the like. Borrowers may be classified based on permitted attributes (e.g., income, wealth, total assets, location, credit history), risk factors, current status (e.g., employed, a student), behaviors of parties (such as behaviors indicating preferences, reliability, and the like), and the like. A condition classifying system may classify a student recipient of a loan based on progress of the student toward a degree, the student's grades or standing in their classes, students' status at the school (matriculated, on probation and the like), the participation of a student in a non-profit activity, a deferment status of the student, and the participation of the student in a public interest activity. Conditions classified by a condition classifying system may include a state of a set of collateral for a loan or a state of an entity relevant to a guarantee for a loan. Conditions classified by a condition classifying system may include a medical condition of a borrower, guarantor, subsidizer, or the like. Conditions classified by a condition classifying system may include compliance with at least one of a law, a regulation, or a policy related to a lending transaction or lending institute. Conditions classified by a condition classifying system may include a condition of an issuer for a bond, a condition of a bond, a rating of a loan-related entity, and the like. Conditions classified by a condition classifying system may include an identify of a machine, a component, or an operational mode. Conditions classified by a condition classifying system may include a state or context (such as a state of a machine, a process, a workflow, a marketplace, a storage system, a network, a data collector, or the like). A condition classifying system may classify a process involving a state or context (e.g., a data storage process, a network coding process, a network selection process, a data marketplace process, a power generation process, a manufacturing process, a refining process, a digging process, a boring process, and/or other process described herein. A condition classifying system may classify a set of loan refinancing actions based on a predicted outcome of the set of loan refinancing actions. A condition classifying system may classify a set of loans as candidates for consolidation based on attributes such as identity of a party, an interest rate, a payment balance, payment terms, payment schedule, a type of loan, a type of collateral, a financial condition of party, a payment status, a condition of collateral, a value of collateral, and the like. A condition classifying system may classify the entities involved in a set of factoring loans, bond issuance activities, mortgage loans, and the like. A condition classifying system may classify a set of entities based on projected outcomes from various loan management activities. A condition classifying system may classify a condition of a set of issuers based on information from Internet of Things data collection and monitoring services, a set of parameters associated with an issuer, a set of social network monitoring and analytic services, and the like. A condition classifying system may classify a set of loan collection actions, loan consolidation actions, loan negotiation actions, loan refinancing actions and the like based on a set of projected outcomes for those activities and entities.

The term subsidized loan, subsidizing a loan, (and similar terms) as utilized herein should be understood broadly. Without limitation to any other aspect or description of the present disclosure, a subsidized loan is the loan of money or an item of value wherein payment of interest on the value of the loan may be deferred, postponed, or delayed, with or without accrual, such as while the borrower is in school, is unemployed, is ill, and the like. In embodiments, a loan may be subsidized when the payment of interest on a portion or subset of the loan is borne or guaranteed by someone other than the borrower. Examples of subsidized loans may include a municipal subsidized loan, a government subsidized loan, a student loan, an asset-backed subsidized loan, and a corporate subsidized loan. An example of a subsidized student loan may include student loans which may be subsidized by the government and on which interest may be deferred or not accrue based on progress of the student toward a degree, the participation of a student in a non-profit activity, a deferment status of the student, and the participation of the student in a public interest activity. An example of a government subsidized housing loan may include governmental subsidies which may exempt the borrower from paying closing costs, first mortgage payment and the like. Conditions for such subsidized loans may include location of the property (rural or urban), income of the borrower, military status of the borrower, ability of the purchased home to meet health and safety standards, a limit on the profits you can earn on the sale of your home, and the like. Certain usages of the word loan may not apply to a subsidized loan but rather to a regular loan. One of skill in the art, having the benefit of the disclosure herein and knowledge about a contemplated system ordinarily available to that person, can readily determine which aspects of the present disclosure will benefit from consideration of a subsidized loan (e.g., in determining the value of the loan, negotiations related to the loan, terms and conditions related to the loan, etc.) wherein the borrower may be relieved of some of the loan obligations common for non-subsidized loans, where the subsidy may include forgiveness, delay or deferment of interest on a loan, or the payment of the interest by a third party. The subsidy may include the payment of closing costs including points, first payment and the like by a person or entity other than the borrower, and/or how to combine processes and systems from the present disclosure to enhance or benefit from title validation.

The term subsidized loan management (and similar terms) as utilized herein should be understood broadly. Without limitation to any other aspect or description of the present disclosure, subsidized loan management may include a plurality of activities and solutions for managing or responding to one or more events related to a subsidized loan wherein such events may include requests for a subsidized loan, offering a subsidized loan, accepting a subsidized loan, providing underwriting information for a subsidized loan, providing a credit report on a borrower seeking a subsidized loan, deferring a required payment as part of the loan subsidy, setting an interest rate for a subsidized loan where a lower interest rate may be part of the subsidy, deferring a payment requirement as part of the loan subsidy, identifying collateral for a loan, validating title for collateral or security for a loan, recording a change in title of property, assessing the value of collateral or security for a loan, inspecting property that is involved in a loan, identifying a change in condition of an entity relevant to a loan, a change in value of an entity that is relevant to a loan, a change in job status of a borrower, a change in financial rating of a lender, a change in financial value of an item offered as a security, providing insurance for a loan, providing evidence of insurance for property related to a loan, providing evidence of eligibility for a loan, identifying security for a loan, underwriting a loan, making a payment on a loan, defaulting on a loan, calling a loan, closing a loan, setting terms and conditions for a loan, foreclosing on property subject to a loan, modifying terms and conditions for a loan, for setting terms and conditions for a loan (such as a principal amount of debt, a balance of debt, a fixed interest rate, a variable interest rate, a payment amount, a payment schedule, a balloon payment schedule, a specification of collateral, a specification of substitutability of collateral, a party, a guarantee, a guarantor, a security, a personal guarantee, a lien, a duration, a covenant, a foreclose condition, a default condition, and a consequence of default), or managing loan-related activities (such as, without limitation, finding parties interested in participating in a loan transaction, handling an application for a loan, underwriting a loan, forming a legal contract for a loan, monitoring performance of a loan, making payments on a loan, restructuring or amending a loan, settling a loan, monitoring collateral for a loan, forming a syndicate for a loan, foreclosing on a loan, collecting on a loan, consolidating a set of loans, analyzing performance of a loan, handling a default of a loan, transferring title of assets or collateral, and closing a loan transaction), and the like. In embodiments, a system for handling a subsidized loan may include classifying a set of parameters of a set of subsidized loans on the basis of data relating to those parameters obtained from an Internet of Things data collection and monitoring service. Classifying the set of parameters of the set of subsidized loans may also be on the bases of data obtained from one or more configurable data collection and monitoring services that leverage social network analytic services, crowd sourcing services, and the like for obtaining parameter data (e.g., determination that a person or entity is qualified for the subsidized loan, determining a social value of providing the subsidized loan or removing a subsidization from a loan, determining that a subsidizing entity is legitimate, determining appropriate subsidization terms based on characteristics of the buyer and/or subsidizer, etc.).

The term foreclose, foreclosure, foreclose or foreclosure condition, default foreclosure collateral, default collateral, (and similar terms) as utilized herein should be understood broadly. Without limitation to any other aspect or description of the present disclosure, foreclose condition, default and the like describe the failure of a borrower to meet the terms of a loan. Without limitation to any other aspect or description of the present disclosure foreclose and foreclosure include processes by which a lender attempts to recover, from a borrower in a foreclose or default condition, the balance of a loan or take away in lieu, the right of a borrower to redeem a mortgage held in security for the loan. Failure to meet the terms of the loan may include failure to make specified payments, failure to adhere to a payment schedule, failure to make a balloon payment, failure to appropriately secure the collateral, failure to sustain collateral in a specified condition (e.g., in good repair), acquisition of a second loan, and the like. Foreclosure may include a notification to the borrower, the public, jurisdictional authorities of the forced sale of an item collateral such as through a foreclosure auction. Upon foreclosure, an item of collateral may be placed on a public auction site (such as eBay, Ne or an auction site appropriate for a particular type of property. The minimum opening bid for the item of collateral may be set by the lender and may cover the balance of the loan, interest on the loan, fees associated with the foreclosure and the like. Attempts to recover the balance of the loan may include the transfer of the deed for an item of collateral in lieu of foreclosure (e.g., a real-estate mortgage where the borrower holds the deed for a property which acts as collateral for the mortgage loan). Foreclosure may include taking possession of or repossessing the collateral (e.g., a car, a sports vehicle such as a boat, ATV, ski-mobile, jewelry). Foreclosure may include securing an item of collateral associated with the loan (such as by locking a connected device, such as a smart lock, smart container, or the like that contains or secures collateral). Foreclosure may include arranging for the shipping of an item of collateral by a carrier, freight forwarder of the like. Foreclosure may include arranging for the transport of an item of collateral by a drone, a robot, or the like for transporting collateral. In embodiments, a loan may allow for the substitution of collateral or the shifting of the lien from an item of collateral initially used to secure the loan to a substitute collateral where the substitute collateral is of higher value (to the lender) than the initial collateral or is an item in which the borrower has a greater equity. The result of the substitution of collateral is that when the loan goes into foreclosure, it is the substitute collateral that may be the subject of a forced sale or seizure. Certain usages of the word default may not apply to such as to foreclose but rather to a regular or default condition of an item. One of skill in the art, having the benefit of the disclosure herein and knowledge about a contemplated system ordinarily available to that person, can readily determine which aspects of the present disclosure will benefit from foreclosure, and/or how to combine processes and systems from the present disclosure to enhance or benefit from foreclosure. Certain considerations for the person of skill in the art, in determining whether the term foreclosure, foreclose condition, default and the like is referring to failure of a borrower to meet the terms of a loan and the related attempts by the lender to recover the balance of the loan or obtain ownership of the collateral.

The terms validation of tile, title validation, validating title, and similar terms, as utilized herein should be understood broadly. Without limitation to any other aspect or description of the present disclosure validation of title and title validation include any efforts to verify or confirm the ownership or interest by an individual or entity in an item of property such as a vehicle, a ship, a plane, a building, a home, real estate property, undeveloped land, a farm, a crop, a municipal facility, a warehouse, a set of inventory, a commodity, a security, a currency, a token of value, a ticket, a cryptocurrency, a consumable item, an edible item, a beverage, a precious metal, an item of jewelry, a gemstone, an item of intellectual property, an intellectual property right, a contractual right, an antique, a fixture, an item of furniture, an item of equipment, a tool, an item of machinery, and an item of personal property. Efforts to verify ownership may include reference to bills of sale, government documentation of transfer of ownership, a legal will transferring ownership, documentation of retirement of liens on the item of property, verification of assignment of Intellectual Property to the proposed borrower in the appropriate jurisdiction, and the like. For real-estate property validation may include a review of deeds and records at a courthouse of a country, a state, a county, or a district in which a building, a home, real estate property, undeveloped land, a farm, a crop, a municipal facility, a vehicle, a ship, a plane, or a warehouse is located or registered. Certain usages of the word validation may not apply to validation of a title or title validation but rather to confirmation that a process is operating correctly, that an individual has been correctly identified using biometric data, that intellectual property rights are in effect, that data is correct and meaningful, and the like. One of skill in the art, having the benefit of the disclosure herein and knowledge about a contemplated system ordinarily available to that person, can readily determine which aspects of the present disclosure will benefit from title validation, and/or how to combine processes and systems from the present disclosure to enhance or benefit from title validation. Certain considerations for the person of skill in the art, in determining whether the term validation is referring to title validation, are specifically contemplated within the scope of the present disclosure.

Without limitation to any other aspect or description of the present disclosure, validation includes any validating system including, without limitation, validating title for collateral or security for a loan, validating conditions of collateral for security or a loan, validating conditions of a guarantee for a loan, and the like. For instance, a validation service may provide lenders a mechanism to deliver loans with more certainty, such as through validating loan or security information components (e.g., income, employment, title, conditions for a loan, conditions of collateral, and conditions of an asset). In a non-limiting example, a validation service circuit may be structured to validate a plurality of loan information components with respect to a financial entity configured to determine a loan condition for an asset. Certain components may not be considered a validating system individually, but may be considered validating in an aggregated system—for example, an Internet of Things component may not be considered a validating component on its own, however an Internet of Things component utilized for asset data collection and monitoring may be considered a validating component when applied to validating a reliability parameter of a personal guarantee for a load when the Internet of Things component is associated with a collateralized asset. In certain embodiments, otherwise similar looking systems may be differentiated in determining whether such systems are for validation. For example, a blockchain-based ledger may be used to validate identities in one instance and to maintain confidential information in another instance. Accordingly, the benefits of the present disclosure may be applied in a wide variety of systems, and any such systems may be considered a system for validation herein, while in certain embodiments a given system may not be considered a validating system herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is a validating system and/or whether aspects of the present disclosure can benefit or enhance the contemplated system include, without limitation: a lending platform having a social network monitoring system for validating the reliability of a guarantee for a loan; a lending platform having an Internet of Things data collection and monitoring system for validating reliability of a guarantee for a loan; a lending platform having a crowdsourcing and automated classification system for validating conditions of an issuer for a bond; a crowdsourcing system for validating quality, title, or other conditions of collateral for a loan; a biometric identify validation application such as utilizing DNA or fingerprints; IoT devices utilized to collectively validate location and identity of a fixed asset that is tagged by a virtual asset tag; validation systems utilizing voting or consensus protocols; artificial intelligence systems trained to recognize and validate events; validating information such as title records, video footage, photographs, or witnessed statements; validation representations related to behavior, such as to validate occurrence of conditions of compliance, to validate occurrence of conditions of default, to deter improper behavior or misrepresentations, to reduce uncertainty, or to reduce asymmetries of information; and the like.

The term underwriting (and similar terms) as utilized herein should be understood broadly. Without limitation to any other aspect or description of the present disclosure, underwriting includes any underwriting, including, without limitation, relating to underwriters, providing underwriting information for a loan, underwriting a debt transaction, underwriting a bond transaction, underwriting a subsidized loan transaction, underwriting a securities transaction, and the like. Underwriting services may be provided by financial entities, such as banks, insurance or investment houses, and the like, whereby the financial entity guarantees payment in case of a determination of a loss condition (e.g., damage or financial loss) and accept the financial risk for liability arising from the guarantee. For instance, a bank may underwrite a loan through a mechanism to perform a credit analysis that may lead to a determination of a loan to be granted, such as through analysis of personal information components related to an individual borrower requesting a consumer loan (e.g., employment history, salary and financial statements publicly available information such as the borrower's credit history), analysis of business financial information components from a company requesting a commercial load (e.g., tangible net worth, ratio of debt to worth (leverage), and available liquidity (current ratio)), and the like. In a non-limiting example, an underwriting services circuit may be structured to underwrite a financial transaction including a plurality of financial information components with respect to a financial entity configured to determine a financial condition for an asset. In certain embodiments, underwriting components may be considered underwriting for some purposes but not for other purposes—for example, an artificial intelligence system to collect and analyze transaction data may be utilized in conjunction with a smart contract platform to monitor loan transactions, but alternately used to collect and analyze underwriting data, such as utilizing a model trained by human expert underwriters. Accordingly, the benefits of the present disclosure may be applied in a wide variety of systems, and any such systems may be considered underwriting herein, while in certain embodiments a given system may not be considered underwriting herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is underwriting and/or whether aspects of the present disclosure can benefit or enhance the contemplated system include, without limitation: a lending platform having an underwriting system for a loan with a set of data-integrated microservices such as including data collection and monitoring services, blockchain services, artificial intelligence services, and smart contract services for underwriting lending entities and transactions; underwriting processes, operations, and services; underwriting data, such as data relating to identities of prospective and actual parties involved insurance and other transactions, actuarial data, data relating to probability of occurrence and/or extent of risk associated with activities, data relating to observed activities and other data used to underwrite or estimate risk; an underwriting application, such as, without limitation, for underwriting any insurance offering, any loan, or any other transaction, including any application for detecting, characterizing or predicting the likelihood and/or scope of a risk, an underwriting or inspection flow about an entity serving a lending solution, an analytics solution, or an asset management solution; underwriting of insurance policies, loans, warranties, or guarantees; a blockchain and smart contract platform for aggregating identity and behavior information for insurance underwriting, such as with an optional distributed ledger to record a set of events, transactions, activities, identities, facts, and other information associated with an underwriting process; a crowdsourcing platform such as for underwriting of various types of loans, and guarantees; an underwriting system for a loan with a set of data-integrated microservices including data collection and monitoring services, blockchain services, artificial intelligence services, and smart contract services for underwriting lending entities and transactions; an underwriting solution to create, configure, modify, set or otherwise handle various rules, thresholds, conditional procedures, workflows, or model parameters; an underwriting action or plan for management a set of loans of a given type or types based on one or more events, conditions, states, actions, secondary loans or transactions to back loans, for collection, consolidation, foreclosure, situations of bankruptcy or insolvency, modifications of existing loans, situations involving market changes, foreclosure activities; adaptive intelligent systems including artificial intelligent models trained on a training set of underwriting activities by experts and/or on outcomes of underwriting actions to generate a set of predictions, classifications, control instructions, plans, models; underwriting system for a loan with a set of data-integrated microservices including data collection and monitoring services, blockchain services, artificial intelligence services, and smart contract services for underwriting lending entities and transactions; and the like.

The term insuring (and similar terms) as utilized herein should be understood broadly. Without limitation to any other aspect or description of the present disclosure, insuring includes any insuring, including, without limitation, providing insurance for a loan, providing evidence of insurance for an asset related to a loan, a first entity accepting a risk or liability for another entity, and the like. Insuring, or insurance, may be a mechanism through which a holder of the insurance is provided protection from a financial loss, such as in a form of risk management against the risk of a contingent or uncertain loss. The insuring mechanism may provide for an insurance, determine the need for an insurance, determine evidence of insurance, and the like, such as related to an asset, transaction for an asset, loan for an asset, security, and the like. An entity which provides insurance may be known as an insurer, insurance company, insurance carrier, underwriter, and the like. For instance, a mechanism for insuring may provide a financial entity with a mechanism to determine evidence of insurance for an asset related to a loan. In a non-limiting example, an insurance service circuit may be structured to determine an evidence condition of insurance for an asset based on a plurality of insurance information components with respect to a financial entity configured to determine a loan condition for an asset. In certain embodiments, components may be considered insuring for some purposes but not for other purposes, for example, a blockchain and smart contract platform may be utilized to manage aspects of a loan transaction such as for identity and confidentiality, but may alternately be utilized to aggregate identity and behavior information for insurance underwriting. Accordingly, the benefits of the present disclosure may be applied in a wide variety of systems, and any such systems may be considered insuring herein, while in certain embodiments a given system may not be considered insuring herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is insuring and/or whether aspects of the present disclosure can benefit or enhance the contemplated system include, without limitation: insurance facilities such as branches, offices, storage facilities, data centers, underwriting operations and others; insurance claims, such as for business interruption insurance, product liability insurance, insurance on goods, facilities, or equipment, flood insurance, insurance for contract-related risks, and many others, as well as claims data relating to product liability, general liability, workers compensation, injury and other liability claims and claims data relating to contracts, such as supply contract performance claims, product delivery requirements, contract claims, claims for damages, claims to redeem points or rewards, claims of access rights, warranty claims, indemnification claims, energy production requirements, delivery requirements, timing requirements, milestones, key performance indicators and others; insurance-related lending; an insurance service, an insurance brokerage service, a life insurance service, a health insurance service, a retirement insurance service, a property insurance service, a casualty insurance service, a finance and insurance service, a reinsurance service; a blockchain and smart contract platform for aggregating identity and behavior information for insurance underwriting; identities of applicants for insurance, identities of parties that may be willing to offer insurance, information regarding risks that may be insured (of any type, without limitation, such as property, life, travel, infringement, health, home, commercial liability, product liability, auto, fire, flood, casualty, retirement, unemployment; distributed ledger may be utilized to facilitate offering and underwriting of microinsurance, such as for defined risks related to defined activities for defined time periods that are narrower than for typical insurance policies; providing insurance for a loan, providing evidence of insurance for property related to a loan; and the like.

The term aggregation (and similar terms) as utilized herein should be understood broadly. Without limitation to any other aspect or description of the present disclosure, an aggregation or to aggregate includes any aggregation including, without limitation, aggregating items together, such as aggregating or linking similar items together (e.g., collateral to provide collateral for a set of loans, collateral items for a set of loans is aggregated in real time based on a similarity in status of the set of items, and the like), collecting data together (e.g., for storage, for communication, for analysis, as training data for a model, and the like), summarizing aggregated items or data into a simpler description, or any other method for creating a whole formed by combining several (e.g., disparate) elements. Further, an aggregator may be any system or platform for aggregating, such as described. Certain components may not be considered aggregation individually but may be considered aggregation in an aggregated system—for example, a collection of loans may not be considered an aggregation of loans of itself but may be an aggregation if collected as such. In a non-limiting example, an aggregation circuit may be structured to provide lenders a mechanism to aggregate loans together from a plurality of loans, such as based on a loan attribute, parameter, term or condition, financial entity, and the like, to become an aggregation of loans. In certain embodiments, an aggregation may be considered an aggregation for some purposes but not for other purposes, for example, an aggregation of asset collateral conditions may be collected for the purpose of aggregating loans together in one instance and for the purpose of determining a default action in another instance. Additionally, in certain embodiments, otherwise similar looking systems may be differentiated in determining whether such systems are aggregators, and/or which type of aggregating systems. For example, a first and second aggregator may both aggregate financial entity data, where the first aggregator aggregates for the sake of building a training set for an analysis model circuit and where the second aggregator aggregates financial entity data for storage in a blockchain-based distributed ledger. Accordingly, the benefits of the present disclosure may be applied in a wide variety of systems, and any such systems may be considered as aggregation herein, while in certain embodiments a given system may not be considered aggregation herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is aggregation and/or whether aspects of the present disclosure can benefit or enhance the contemplated system include, without limitation forward market demand aggregation (e.g., blockchain and smart contract platform for forward market demand aggregation, interest expressed or committed in a demand aggregation interface, blockchain used to aggregate future demand in a forward market with respect to a variety of products and services, process a set of potential configurations having different parameters for a subset of configurations that are consistent with each other and the subset of configurations used to aggregate committed future demand for the offering that satisfies a sufficiently large subset at a profitable price, and the like); correlated aggregated data (including trend information) on worker ages, credentials, experience (including by process type) with data on the processes in which those workers are involved; demand for accommodations aggregated in advance and conveniently fulfilled by automatic recognition of conditions that satisfy pre-configured commitments represented on a blockchain (e.g., distributed ledger); transportation offerings aggregated and fulfilled (e.g., with a wide range of pre-defined contingencies); aggregation of goods and services on the blockchain (e.g., a distributed ledger used for demand planning); with respect to a demand aggregation interface (e.g., presented to one or more consumers); aggregation of multiple submissions; aggregating identity and behavior information (e.g., insurance underwriting); accumulation and aggregation of multiple parties; aggregation of data for a set of collateral; aggregated value of collateral or assets (e.g., based on real time condition monitoring, rea-time market data collection and integration, and the like); aggregated tranches of loans; collateral for smart contract aggregated with other similar collateral; and the like.

The term linking (and similar terms) as utilized herein should be understood broadly. Without limitation to any other aspect or description of the present disclosure, linking includes any linking, including, without limitation, linking as a relationship between two things or situations (e.g., where one thing affects the other). For instance, linking a subset of similar items such as collateral to provide collateral for a set of loans. Certain components may not be considered linked individually, but may be considered in a process of linking in an aggregated system—for example, a smart contracts circuit may be structured to operate in conjunction with a blockchain circuit as part of a loan processing platform but where the smart contracts circuit processes contracts without storing information through the blockchain circuit, however the two circuits could be linked through the smart contracts circuit linking financial entity information through a distributed ledger on the blockchain circuit. In certain embodiments, linking may be considered linking for some purposes but not for other purposes, for example, linking goods and services for users and radio frequency linking between access points are different forms of linking, where the linking of goods and services for users links thinks together while an RF link is a communications link between transceivers. Additionally, in certain embodiments, otherwise similar looking systems may be differentiated in determining whether such system are linking, and/or which type of linking. For example, linking similar data together for analysis is different from linking similar data together for graphing. Accordingly, the benefits of the present disclosure may be applied in a wide variety of systems, and any such systems may be considered linking herein, while in certain embodiments a given system may not be considered a linking herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is linking and/or whether aspects of the present disclosure can benefit or enhance the contemplated system include, without limitation linking marketplaces or external marketplaces with a system or platform; linking data (e.g., data cluster including links and nodes); storage and retrieval of data linked to local processes; links (e.g., with respect to nodes) in a common knowledge graph; data linked to proximity or location (e.g., of the asset); linking to an environment (e.g., goods, services, assets, and the like); linking events (e.g., for storage such as in a blockchain, for communication or analysis); linking ownership or access rights; linking to access tokens (e.g., travel offerings linked to access tokens); links to one or more resources (e.g., secured by cryptographic or other techniques); linking a message to a smart contract; and the like.

The term indicator of interest (and similar terms) as utilized herein should be understood broadly. Without limitation to any other aspect or description of the present disclosure, an indicator of interest includes any indicator of interest including, without limitation, an indicator of interest from a user or plurality of users or parties related to a transaction and the like (e.g., parties interested in participating in a loan transaction), the recording or storing of such an interest (e.g., a circuit for recording an interest input from a user, entity, circuit, system, and the like), a circuit analyzing interest related data and setting an indicator of interest (e.g., a circuit setting or communicating an indicator based on inputs to the circuit, such as from users, parties, entities, systems, circuits, and the like), a model trained to determine an indicator of interest from input data related to an interest by one of a plurality of inputs from users, parties, or financial entities, and the like. Certain components may not be considered indicators of interest individually, but may be considered an indicator of interest in an aggregated system, for example, a party may seek information relating to a transaction such as though a translation marketplace where the party is interested in seeking information, but that may not be considered an indicator of interest in a transaction. However, when the party asserts a specific interest (e.g., through a user interface with control inputs for indicating interest) the party's interest may be recorded (e.g., in a storage circuit, in a blockchain circuit), analyzed (e.g., through an analysis circuit, a data collection circuit), monitored (e.g., through a monitoring circuit), and the like. In a non-limiting example, indicators of interest may be recorded (e.g., in a blockchain through a distributed ledger) from a set of parties with respect to the product, service, or the like, such as ones that define parameters under which a party is willing to commit to purchase a product or service. In certain embodiments, an indicator of interest may be considered an indicator of interest for some purposes but not for other purposes—for example, a user may indicate an interest for a loan transaction but that does not necessarily mean the user is indicating an interest in providing a type of collateral related to the loan transaction. For instance, a data collection circuit may record an indicator of interest for the transaction but may have a separate circuit structure for determining an indication of interest for collateral. Additionally, in certain embodiments, otherwise similar looking systems may be differentiated in determining whether such system are determining an indication of interest, and/or which type of indicator of interest exists. For example, one circuit or system may collect data from a plurality of parties to determine an indicator of interest in securing a loan and a second circuit or system may collect data from a plurality of parties to determine an indicator of interest in determining ownership rights related to a loan. Accordingly, the benefits of the present disclosure may be applied in a wide variety of systems, and any such systems may be considered an indicator of interest herein, while in certain embodiments a given system may not be considered an indicator of interest herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is an indicator of interest and/or whether aspects of the present disclosure can benefit or enhance the contemplated system include, without limitation parties indicating an interest in participating in a transaction (e.g., a loan transaction), parties indicating an interest in securing in a product or service, recording or storing an indication of interest (e.g., through a storage circuit or blockchain circuit), analyzing an indication of interest (e.g., through a data collection and/or monitoring circuit), and the like.

The term accommodations (and similar terms) as utilized herein should be understood broadly. Without limitation to any other aspect or description of the present disclosure, an accommodation includes any service, activity, event, and the like such as including, without limitation, a room, group of rooms, table, seating, building, event, shared spaces offered by individuals (e.g., Airbnb spaces), bed-and-breakfasts, workspaces, conference rooms, convention spaces, fitness accommodations, health and wellness accommodations, dining accommodations, and the like, in which someone may live, stay, sit, reside, participate, and the like. As such, an accommodation may be purchased (e.g., a ticket through a sports ticketing application), reserved or booked (e.g., a reservation through a hotel reservation application), provided as a reward or gift, traded or exchanged (e.g., through a marketplace), provided as an access right (e.g., offering by way of an aggregation demand), provided based on a contingency (e.g., a reservation for a room being contingent on the availability of a nearby event), and the like. Certain components may not be considered an accommodation individually but may be considered an accommodation in an aggregated system—for example, a resource such as a room in a hotel may not in itself be considered an accommodation but a reservation for the room may be. For instance, a blockchain and smart contract platform for forward market rights for accommodations may provide a mechanism to provide access rights with respect to accommodations. In a non-limiting example, a blockchain circuit may be structured to store access rights in a forward demand market, where the access rights may be stored in a distributed ledger with related shared access to a plurality of actionable entities. In certain embodiments, an accommodation may be considered an accommodation for some purposes but not for other purposes, for example, a reservation for a room may be an accommodation on its own, but may not be accommodation that is satisfied if a related contingency is not met as agreed upon at the time of the e.g., reservation. Additionally, in certain embodiments, otherwise similar looking systems may be differentiated in determining whether such systems are related to an accommodation, and/or which type of accommodation. For example, an accommodation offering may be made based on different systems, such as one where the accommodation offering is determined by a system collecting data related to forward demand and a second one where the accommodation offering is provided as a reward based on a system processing a performance parameter. Accordingly, the benefits of the present disclosure may be applied in a wide variety of systems, and any such systems may be considered as related to an accommodation herein, while in certain embodiments a given system may not be considered related to an accommodation herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is related to accommodation and/or whether aspects of the present disclosure can benefit or enhance the contemplated system include, without limitation accommodations provided as determined through a service circuit, trading or exchanging services (e.g., through an application and/or user interface), as an accommodation offering such as with respect to a combination of products, services, and access rights, processed (e.g., aggregation demand for the offering in a forward market), accommodation through booking in advance, accommodation through booking in advance upon meeting a certain condition (e.g., relating to a price within a given time window), and the like.

The term contingencies (and similar terms) as utilized herein should be understood broadly. Without limitation to any other aspect or description of the present disclosure, a contingency includes any contingency including, without limitation, any action that is dependent upon a second action. For instance, a service may be provided as contingent on a certain parameter value, such as collecting data as condition upon an asset tag indication from an Internet of Things circuit. In another instance, an accommodation such as a hotel reservation may be contingent upon a concert (local to the hotel and at the same time as the reservation) proceeding as scheduled. Certain components may not be considered as relating to a contingency individually, but may be considered related to a contingency in an aggregated system—for example, a data input collected from a data collection service circuit may be stored, analyzed, processed, and the like, and not be considered with respect to a contingency, however a smart contracts service circuit may apply a contract term as being contingent upon the collected data. For instance, the data may indicate a collateral status with respect to a loan transaction, and the smart contracts service circuit may apply that data to a term of contract that depends upon the collateral. In certain embodiments, a contingency may be considered contingency for some purposes but not for other purposes—for example, a delivery of contingent access rights for a future event may be contingent upon a loan condition being satisfied, but the loan condition on its own may not be considered a contingency in the absence of the contingency linkage between the condition and the access rights. Additionally, in certain embodiments, otherwise similar looking systems may be differentiated in determining whether such systems are related to a contingency, and/or which type of contingency. For example, two algorithms may both create a forward market event access right token, but where the first algorithm creates the token free of contingencies and the second algorithm creates a token with a contingency for delivery of the token. Accordingly, the benefits of the present disclosure may be applied in a wide variety of systems, and any such systems may be considered a contingency herein, while in certain embodiments a given system may not be considered a contingency herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is a contingency and/or whether aspects of the present disclosure can benefit or enhance the contemplated system include, without limitation a forward market operated within or by the platform may be a contingent forward market, such as one where a future right is vested, is triggered, or emerges based on the occurrence of an event, satisfaction of a condition, or the like; a blockchain used to make a contingent market in any form of event or access token by securely storing access rights on a distributed ledger; setting and monitoring pricing for contingent access rights, underlying access rights, tokens, fees and the like; optimizing offerings, timing, pricing, or the like, to recognize and predict patterns, to establish rules and contingencies; exchanging contingent access rights or underlying access rights or tokens access tokens and/or contingent access tokens; creating a contingent forward market event access right token where a token may be created and stored on a blockchain for contingent access right that could result in the ownership of a ticket; discovery and delivery of contingent access rights to future events; contingencies that influence or represent future demand for an offering, such as including a set of products, services, or the like; pre-defined contingencies; optimized offerings, timing, pricing, or the like, to recognize and predict patterns, to establish rules and contingencies; creation of a contingent future offering within the dashboard; contingent access rights that may result in the ownership of the virtual good or each smart contract to purchase the virtual good if and when it becomes available under defined conditions; and the like.

The term level of service (and similar terms) as utilized herein should be understood broadly. Without limitation to any other aspect or description of the present disclosure, a level of service includes any level of service including, without limitation, any qualitative or quantitative measure of the extent to which a service is provided, such as, and without limitation, a first class vs. business class service (e.g., travel reservation or postal delivery), the degree to which a resource is available (e.g., service level A indicating that the resource is highly available vs. service level C indicating that the resource is constrained, such as in terms of traffic flow restrictions on a roadway), the degree to which an operational parameter is performing (e.g., a system is operating at a high state of service vs a low state of service, and the like. In embodiments, level of service may be multi-modal such that the level of service is variable where a system or circuit provides a service rating (e.g., where the service rating is used as an input to an analytical circuit for determining an outcome based on the service rating). Certain components may not be considered relative to a level of service individually, but may be considered relative to a level of service in an aggregated system, for example a system for monitoring a traffic flow rate may provide data on a current rate but not indicate a level of service, but when the determined traffic flow rate is provided to a monitoring circuit the monitoring circuit may compare the determined traffic flow rate to past traffic flow rates and determine a level of service based on the comparison. In certain embodiments, a level of service may be considered a level of service for some purposes but not for other purposes, for example, the availability of first class travel accommodation may be considered a level of service for determining whether a ticket will be purchased but not to project a future demand for the flight. Additionally, in certain embodiments, otherwise similar looking systems may be differentiated in determining whether such system utilizes a level of service, and/or which type of level of service. For example, an artificial intelligence circuit may be trained on past level of service with respect to traffic flow patterns on a certain freeway and used to predict future traffic flow patterns based on current flow rates, but a similar artificial intelligence circuit may predict future traffic flow patterns based on the time of day. Accordingly, the benefits of the present disclosure may be applied in a wide variety of systems, and any such systems may be considered with respect to levels of service herein, while in certain embodiments a given system may not be considered with respect to levels of service herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is a level of service and/or whether aspects of the present disclosure can benefit or enhance the contemplated system include, without limitation transportation or accommodation offerings with predefined contingencies and parameters such as with respect to price, mode of service, and level of service; warranty or guarantee application, transportation marketplace, and the like.

The term payment (and similar terms) as utilized herein should be understood broadly. Without limitation to any other aspect or description of the present disclosure, a payment includes any payment including, without limitation, an action or process of paying (e.g., a payment to a loan) or of being paid (e.g., a payment from insurance), an amount paid or payable (e.g., a payment of $1000 being made), a repayment (e.g., to pay back a loan), a mode of payment (e.g., use of loyalty programs, rewards points, or particular currencies, including cryptocurrencies) and the like. Certain components may not be considered payments individually, but may be considered payments in an aggregated system—for example, submitting an amount of money may not be considered a payment as such, but when applied to a payment to satisfy the requirement of a loan may be considered a payment (or repayment). For instance, a data collection circuit may provide lenders a mechanism to monitor repayments of a loan. In a non-limiting example, the data collection circuit may be structured to monitor the payments of a plurality of loan components with respect to a financial loan contract configured to determine a loan condition for an asset. In certain embodiments, a payment may be considered a payment for some purposes but not for other purposes—for example, a payment to a financial entity may be for a repayment amount to pay back the loan, or it may be to satisfy a collateral obligation in a loan default condition. Additionally, in certain embodiments, otherwise similar looking systems may be differentiated in determining whether such system are related to a payment, and/or which type of payment. For example, funds may be applied to reserve an accommodation or to satisfy the delivery of services after the accommodation has been satisfied. Accordingly, the benefits of the present disclosure may be applied in a wide variety of systems, and any such systems may be considered a payment herein, while in certain embodiments a given system may not be considered a payment herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is a payment and/or whether aspects of the present disclosure can benefit or enhance the contemplated system include, without limitation, deferring a required payment; deferring a payment requirement; payment of a loan; a payment amount; a payment schedule; a balloon payment schedule; payment performance and satisfaction; modes of payment; and the like.

The term location (and similar terms) as utilized herein should be understood broadly. Without limitation to any other aspect or description of the present disclosure, a location includes any location including, without limitation, a particular place or position of a person, place, or item, or location information regarding the position of a person, place, or item, such as a geolocation (e.g., geolocation of a collateral), a storage location (e.g., the storage location of an asset), a location of a person (e.g., lender, borrower, worker), location information with respect to the same, and the like. Certain components may not be considered with respect to location individually, but may be considered with respect to location in an aggregated system, for example, a smart contract circuit may be structured to specify a requirement for a collateral to be stored at a fixed location but not specify the specific location for a specific collateral. In certain embodiments, a location may be considered a location for some purposes but not for other purposes—for example, the address location of a borrower may be required for processing a loan in one instance, and a specific location for processing a default condition in another instance. Additionally, in certain embodiments, otherwise similar looking systems may be differentiated in determining whether such system are a location, and/or which type of location. For example, the location of a music concert may be required to be in a concert hall seating 10,000 people in one instance but specify the location of an actual concert hall in another. Accordingly, the benefits of the present disclosure may be applied in a wide variety of systems, and any such systems may be considered with respect to a location herein, while in certain embodiments a given system may not be considered with respect to a location herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is considered with respect to a location and/or whether aspects of the present disclosure can benefit or enhance the contemplated system include, without limitation a geolocation of an item or collateral; a storage location of item or asset; location information; location of a lender or a borrower; location-based product or service targeting application; a location-based fraud detection application; indoor location monitoring systems (e.g., cameras, IR systems, motion-detection systems); locations of workers (including routes taken through a location); location parameters; event location; specific location of an event; and the like.

The term route (and similar terms) as utilized herein should be understood broadly. Without limitation to any other aspect or description of the present disclosure, a route includes any route including, without limitation, a way or course taken in getting from a starting point to a destination, to send or direct along a specified course, and the like. Certain components may not be considered with respect to a route individually, but may be considered a route in an aggregated system—for example, a mobile data collector may specify a requirement for a route for collecting data based on an input from a monitoring circuit, but only in receiving that input does the mobile data collector determine what route to take and begin traveling along the route. In certain embodiments, a route may be considered a route for some purposes but not for other purposes—for example possible routes through a road system may be considered differently than specific routes taken through from one location to another location. Additionally, in certain embodiments, otherwise similar looking systems may be differentiated in determining whether such systems are specified with respect to a location, and/or which types of locations. For example, routes depicted on a map may indicate possible routes or actual routes taken by individuals. Accordingly, the benefits of the present disclosure may be applied in a wide variety of systems, and any such systems may be considered with respect to a route herein, while in certain embodiments a given system may not be considered with respect to a route herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is utilizing a route and/or whether aspects of the present disclosure can benefit or enhance the contemplated system include, without limitation delivery routes; routes taken through a location; heat map showing routes traveled by customers or workers within an environment; determining what resources are deployed to what routes or types of travel; direct route or multi-stop route, such as from the destination of the consumer to a specific location or to wherever an event takes place; a route for a mobile data collector; and the like.

The term future offering (and similar terms) as utilized herein should be understood broadly. Without limitation to any other aspect or description of the present disclosure, a future offing includes any offer of an item or service in the future including, without limitation, a future offer to provide an item or service, a future offer with respect to a proposed purchase, a future offering made through a forward market platform, a future offering determined by a smart contract circuit, and the like. Further, a future offering may be a contingent future offer, or an offer based on conditions resulting on the offer being a future offering, such as where the future offer is contingent upon or with the conditions imposed by a predetermined condition (e.g., a security may be purchased for $1000 at a set future date contingent upon a predetermined state of a market indicator). Certain components may not be considered a future offering individually, but may be considered a future offering in an aggregated system—for example, an offer for a loan may not be considered a future offering if the offer is not authorized through a collective agreement amongst a plurality of parties related to the offer, but may be considered a future offer once a vote has been collected and stored through a distributed ledger, such as through a blockchain circuit. In certain embodiments, a future offering may be considered a future offering for some purposes but not for other purposes—for example, a future offering may be contingent upon a condition being met in the future, and so the future offering may not be considered a future offer until the condition is met. Additionally, in certain embodiments, otherwise similar looking systems may be differentiated in determining whether such systems are future offerings, and/or which type of future offerings. For example, two security offerings may be determined to be offerings to be made at a future time, however, one may have immediate contingences to be met and thus may not be considered to be a future offering but rather an immediate offering with future declarations. Accordingly, the benefits of the present disclosure may be applied in a wide variety of systems, and any such systems may be considered in association with a future offering herein, while in certain embodiments a given system may not be considered in association with a future offering herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is in association with a future offering and/or whether aspects of the present disclosure can benefit or enhance the contemplated system include, without limitation a forward offering, a contingent forward offering, a forward offing in a forward market platform (e.g., for creating a future offering or contingent future offering associated with identifying offering data from a platform-operated marketplace or external marketplace); a future offering with respect to entering into a smart contract (e.g., by executing an indication of a commitment to purchase, attend, or otherwise consume a future offering), and the like.

The term access right (and derivatives or variations) as utilized herein may be understood broadly to describe an entitlement to acquire or possess a property, article, or other thing of value. A contingent access right may be conditioned upon a trigger or condition being met before such an access right becomes entitled, vested or otherwise defensible. An access right or contingent access right may also serve specific purposes or be configured for different applications or contexts, such as, without limitation, loan-related actions or any service or offering. Without limitation, notices may be required to be provided to the owner of a property, article, or item of value before such access rights or contingent access rights are exercised. Access rights and contingent access rights in various forms may be included where discussing a legal action, a delinquent or defaulted loan or agreement, or other circumstances where a lender may be seeking remedy, without limitation. One of skill in the art, having the benefit of the disclosure herein and knowledge ordinarily available about a contemplated system, can readily determine the value of such rights implemented in an embodiment. While specific examples of access rights and contingent access rights are described herein for purposes of illustration, any embodiment benefitting from the disclosures herein, and any considerations understood to one of skill in the art having the benefit of the disclosures herein, are specifically contemplated within the scope of the present disclosure.

The term smart contract (and other forms or variations) as utilized herein may be understood broadly to describe a method, system, connected resource or wide area network offering one or more resources useful to assist or perform actions, tasks or things by embodiments disclosed herein. A smart contract may be a set of steps or a process to negotiate, administrate, restructure, or implement an agreement or loan between parties. A smart contract may also be implemented as an application, website, FTP site, server, appliance or other connected component or Internet related system that renders resources to negotiate, administrate, restructure, or implement an agreement or loan between parties. A smart contract may be a self-contained system, or may be part of a larger system or component that may also be a smart contract. For example, a smart contract may refer to a loan or an agreement itself, conditions or terms, or may refer to a system to implement such a loan or agreement. In certain embodiments, a smart contract circuit or robotic process automation system may incorporate or be incorporated into automatic robotic process automation system to perform one or more purposes or tasks, whether part of a loan or transaction process, or otherwise. One of skill in the art, having the benefit of the disclosure herein and knowledge ordinarily available about a contemplated system can readily determine the purposes and use of this term as it relates to a smart contract in various forms, embodiments and contexts disclosed herein.

The term allocation of reward (and variations) as utilized herein may be understood broadly to describe a thing or consideration allocated or provided as consideration, or provided for a purpose. The allocation of rewards can be of a financial type, or non-financial type, without limitation. A specific type of allocation of reward may also serve a number of different purposes or be configured for different applications or contexts, such as, without limitation: a reward event, claims for rewards, monetary rewards, rewards captured as a data set, rewards points, and other forms of rewards. Thus an allocation of rewards may be provided as a consideration within the context of a loan or agreement. Systems may be utilized to allocate rewards. The allocation of rewards in various forms may be included where discussing a particular behavior, or encouragement of a particular behavior, without limitation. An allocation of a reward may include an actual dispensation of the award, and/or a recordation of the reward. The allocation of rewards may be performed by a smart contract circuit or a robotic processing automation system. One of skill in the art, having the benefit of the disclosure herein and knowledge ordinarily available about a contemplated system, can readily determine the value of the allocation of rewards in an embodiment. While specific examples of the allocation of rewards are described herein for purposes of illustration, any embodiment benefitting from the disclosures herein, and any considerations understood to one of skill in the art having the benefit of the disclosures herein, are specifically contemplated within the scope of the present disclosure.

The term satisfaction of parameters or conditions (and other derivatives, forms, or variations) as utilized herein may be understood broadly to describe completion, presence or proof of parameters or conditions that have been met. The term generally may relate to a process of determining such satisfaction of parameters or conditions, or may relate to the completion of such a process with a result, without limitation. Satisfaction may result in a successful outcome of other triggers or conditions or terms that may come into execution, without limitation. Satisfaction of parameters or conditions may occur in many different contexts of contracts or loans, such as lending, refinancing, consolidation, factoring, brokering, foreclosure, and data processing (e.g., data collection), or combinations thereof, without limitation. Satisfaction of parameters or conditions may be used in the form of a noun (e.g., the satisfaction of the debt repayment), or may be used in a verb form to describe the process of determining a result to parameters or conditions. For example, a borrower may have satisfaction of parameters by making a certain number of payments on time, or may cause satisfaction of a condition allowing access rights to an owner if a loan defaults, without limitation. In certain embodiments, a smart contract or robotic process automation system may perform or determine satisfaction of parameters or conditions for one or more of the parties and process appropriate tasks for satisfaction of parameters or conditions. In some cases satisfaction of parameters or conditions by the smart contract or robotic process automation system may not complete or be successful, and depending upon such outcomes, this may enable automated action or trigger other conditions or terms. One of skill in the art, having the benefit of the disclosure herein and knowledge ordinarily available about a contemplated system can readily determine the purposes and use of this term in various forms, embodiments and contexts disclosed herein.

The term information (and other forms such as info or informational, without limitation) as utilized herein may be understood broadly in a variety of contexts with respect to an agreement or a loan. The term generally may relate to a large context, such as information regarding an agreement or loan, or may specifically relate to a finite piece of information (e.g., a specific detail of an event that happened on a specific date). Thus, information may occur in many different contexts of contracts or loans, and may be used in the contexts, without limitation of evidence, transactions, access, and the like. Or, without limitation, information may be used in conjunction with stages of an agreement or transaction, such as lending, refinancing, consolidation, factoring, brokering, foreclosure, and information processing (e.g., data or information collection), or combinations thereof. For example, information as evidence, transaction, access, etc. may be used in the form of a noun (e.g., the information was acquired from the borrower), or may refer as a noun to an assortment of informational items (e.g., the information about the loan may be found in the smart contract), or may be used in the form of characterizing as an adjective (e.g., the borrower was providing an information submission). For example, a lender may collect an overdue payment from a borrower through an online payment, or may have a successful collection of overdue payments acquired through a customer service telephone call. In certain embodiments, a smart contract circuit or robotic process automation system may perform collection, administration, calculating, providing, or other tasks for one or more of the parties and process appropriate tasks relating to information (e.g., providing notice of an overdue payment). In some cases information by the smart contract circuit or robotic process automation system may be incomplete, and depending upon such outcomes this may enable automated action or trigger other conditions or terms. One of skill in the art, having the benefit of the disclosure herein and knowledge ordinarily available about a contemplated system can readily determine the purposes and use of information as evidence, transaction, access, etc. in various forms, embodiments and contexts disclosed herein.

Information may be linked to external information (e.g., external sources). The term more specifically may relate to the acquisition, parsing, receiving, or other relation to an external origin or source, without limitation. Thus, information linked to external information or sources may be used in conjunction with stages of an agreement or transaction, such as lending, refinancing, consolidation, factoring, brokering, foreclosure, and information processing (e.g., data or information collection), or combinations thereof. For example, information linked to external information may change as the external information changes, such as a borrower's credit score, which is based on an external source. In certain embodiments, a smart contract circuit or robotic process automation system may perform acquisition, administration, calculating, receiving, updating, providing or other tasks for one or more of the parties and process appropriate tasks relating to information that is linked to external information. In some cases information that is linked to external information by the smart contract or robotic process automation system may be incomplete, and depending upon such outcomes this may enable automated action or trigger other conditions or terms. One of skill in the art, having the benefit of the disclosure herein and knowledge ordinarily available about a contemplated system can readily determine the purposes and use of this term in various forms, embodiments and contexts disclosed herein.

Information that is a part of a loan or agreement may be separated from information presented in an access location. The term more specifically may relate to the characterization that information can be apportioned, split, restricted, or otherwise separated from other information within the context of a loan or agreement. Thus, information presented or received on an access location may not necessarily be the whole information available for a given context. For example, information provided to a borrower may be different information received by a lender from an external source, and may be different than information received or presented from an access location. In certain embodiments, a smart contract circuit or robotic process automation system may perform separation of information or other tasks for one or more of the parties and process appropriate tasks. One of skill in the art, having the benefit of the disclosure herein and knowledge ordinarily available about a contemplated system, can readily determine the purposes and use of this term in various forms, embodiments and contexts disclosed herein.

The term encryption of information and control of access (and other related terms) as utilized herein may be understood broadly to describe generally whether a party or parties may observe or possess certain information, actions, events, or activities relating to a transaction or loan. Encryption of information may be utilized to prevent a party from accessing, observing, or receiving information, or may alternatively be used to prevent parties outside the transaction or loan from being able to access, observe or receive confidential (or other) information. Control of access to information relates to the determination of whether a party is entitled to such access of information. Encryption of information or control of access may occur in many different contexts of loans, such as lending, refinancing, consolidation, factoring, brokering, foreclosure, administration, negotiating, collecting, procuring, enforcing, and data processing (e.g., data collection), or combinations thereof, without limitation. An encryption of information or control of access to information may refer to a single instance, or may characterize a larger amount of information, actions, events, or activities, without limitation. For example, a borrower or lender may have access to information about a loan, but other parties outside the loan or agreement may not be able to access the loan information due to encryption of the information, or a control of access to the loan details. In certain embodiments, a smart contract circuit or robotic process automation system may perform encryption of information or control of access to information for one or more of the parties and process appropriate tasks for encryption or control of access of information. One of skill in the art, having the benefit of the disclosure herein and knowledge ordinarily available about a contemplated system can readily determine the purposes and use of this term in various forms, embodiments and contexts disclosed herein.

The term potential access party list (and other related terms) as utilized herein may be understood broadly to describe generally whether a party or parties may observe or possess certain information, actions, events, or activities relating to a transaction or loan. A potential access party list may be utilized to authorize one or more parties to access, observe or receive information, or may alternatively be used to prevent parties from being able to do so. A potential access party list information relates to the determination of whether a party (either on the potential access party list or not on the list) is entitled to such access of information. A potential access party list may occur in many different contexts of loans, such as lending, refinancing, consolidation, factoring, brokering, foreclosure, administration, negotiating, collecting, procuring, enforcing and data processing (e.g., data collection), or combinations thereof, without limitation. A potential access party list may refer to a single instance, or may characterize a larger amount of parties or information, actions, events, or activities, without limitation. For example, a potential access party list may grant (or deny) access to information about a loan, but other parties outside potential access party list may not be able to (or may be granted) access the loan information. In certain embodiments, a smart contract circuit or robotic process automation system may perform administration or enforcement of a potential access party list for one or more of the parties and process appropriate tasks for encryption or control of access of information. One of skill in the art, having the benefit of the disclosure herein and knowledge ordinarily available about a contemplated system can readily determine the purposes and use of this term in various forms, embodiments and contexts disclosed herein.

The term offering, making an offer, and similar terms as utilized herein should be understood broadly. Without limitation to any other aspect or description of the present disclosure, an offering includes any offer of an item or service including, without limitation, an insurance offering, a security offering, an offer to provide an item or service, an offer with respect to a proposed purchase, an offering made through a forward market platform, a future offering, a contingent offering, offers related to lending (e.g., lending, refinancing, collection, consolidation, factoring, brokering, foreclosure), an offering determined by a smart contract circuit, an offer directed to a customer/debtor, an offering directed to a provider/lender, a 3rd party offer (e.g., regulator, auditor, partial owner, tiered provider) and the like. Offerings may include physical goods, virtual goods, software, physical services, access rights, entertainment content, accommodations, or many other items, services, solutions, or considerations. In an example, a third party offer may be to schedule a band instead of just an offer of tickets for sale. Further, an offer may be based on pre-determined conditions or contingencies. Certain components may not be considered an offering individually, but may be considered an offering in an aggregated system—for example, an offer for insurance may not be considered an offering if the offer is not approved by one or more parties related to the offer, however once approval has been granted, it may be considered an offer. Accordingly, the benefits of the present disclosure may be applied in a wide variety of systems, and any such systems may be considered in association with an offering herein, while in certain embodiments a given system may not be considered in association with an offering herein. One of skill in the art, having the benefit of the disclosure herein and knowledge about a contemplated system ordinarily available to that person, can readily determine which aspects of the present disclosure will benefit a particular system, and/or how to combine processes and systems from the present disclosure to enhance operations of the contemplated system. Certain considerations for the person of skill in the art, in determining whether a contemplated system is in association with an offering and/or whether aspects of the present disclosure can benefit or enhance the contemplated system include, without limitation the item or service being offered, a contingency related to the offer, a way of tracking if a contingency or condition has been met, an approval of the offering, an execution of an exchange of consideration for the offering, and the like.

The term artificial intelligence (AI) solution should be understood broadly. Without limitation to any other aspect of the present disclosure, an AI solution includes a coordinated group of AI related aspects to perform one or more tasks or operations as set forth throughout the present disclosure. An example AI solution includes one or more AI components, including any AI components set forth herein, including at least a neural network, an expert system, and/or a machine learning component. The example AI solution may include as an aspect the types of components of the solution, such as a heuristic AI component, a model based AI component, a neural network of a selected type (e.g., recursive, convolutional, perceptron, etc.), and/or an AI component of any type having a selected processing capability (e.g., signal processing, frequency component analysis, auditory processing, visual processing, speech processing, text recognition, etc.). Without limitation to any other aspect of the present disclosure, a given AI solution may be formed from the number and type of AI components of the AI solution, the connectivity of the AI components (e.g., to each other, to inputs from a system including or interacting with the AI solution, and/or to outputs to the system including or interacting with the AI solution). The given AI solution may additionally be formed from the connection of the AI components to each other within the AI solution, and to boundary elements (e.g., inputs, outputs, stored intermediary data, etc.) in communication with the AI solution. The given AI solution may additionally be formed from a configuration of each of the AI components of the AI solution, where the configuration may include aspects such as: model calibrations for an AI component; connectivity and/or flow between AI components (e.g., serial and/or parallel coupling, feedback loops, logic junctions, etc.); the number, selected input data, and/or input data processing of inputs to an AI component; a depth and/or complexity of a neural network or other components; a training data description of an AI component (e.g., training data parameters such as content, amount of training data, statistical description of valid training data, etc.); and/or a selection and/or hybrid description of a type for an AI component. An AI solution includes a selection of AI elements, flow connectivity of those AI elements, and/or configuration of those AI elements.

One of skill in the art, having the benefit of the present disclosure, can readily determine an AI solution for a given system, and/or configure operations to perform a selection and/or configuration operation for an AI solution for a given system. Certain considerations to determining an AI solution, and/or configuring operations to perform a selection and/or configuration operation for an AI solution include, without limitation: an availability of AI components and/or component types for a given implementation; an availability of supporting infrastructure to implement given AI components (e.g., data input values available, including data quality, level of service, resolution, sampling rate, etc.; availability of suitable training data for a given AI solution; availability of expert inputs, such as for an expert system and/or to develop a model training data set; regulatory and/or policy based considerations including permitted action by the AI solution, requirements for acquisition and/or retention of sensitive data, difficult to obtain data, and/or expensive data); operational considerations for a system including or interacting with the AI solution, including response time specifications, safety considerations, liability considerations, etc.; available computing resources such as processing capability, network communication capability, and/or memory storage capability (e.g., to support initial data, training data, input data such as cached, buffered, or stored input data, iterative improvement state data, output data such as cached, buffered, or stored output data, and/or intermediate data storage, such as data to support ongoing calculations, historical data, and/or accumulation data); the types of tasks to be performed by the AI solution, and the suitability of AI components for those tasks, sensitivity of AI components performing the tasks (e.g., variability of the output space relative to a disturbance size of the input space); the interactions of AI components within the entire AI solution (e.g., a low capability rationality AI component may be coupled with a higher capability AI component that may provide high sensitivity and/or unbounded response to inputs); and/or model implementation considerations (e.g., requirements to re-calibrate, aging constraints of a model, etc.).

A selected and/or configured AI solution may be utilized with any of the systems, procedures, and/or aspects of embodiments as set forth throughout the present disclosure. For example, a system utilizing an expert system may include the expert system as all or a part of a selected, configured AI solution. In another example, a system utilizing a neural network, and/or a combination of neural networks, may include the neural network(s) as all or a part of a selected, configured AI solution. The described aspects of an AI solution, including the selection and configuration of the AI solution, are non-limiting illustrations.

### Transaction Platform

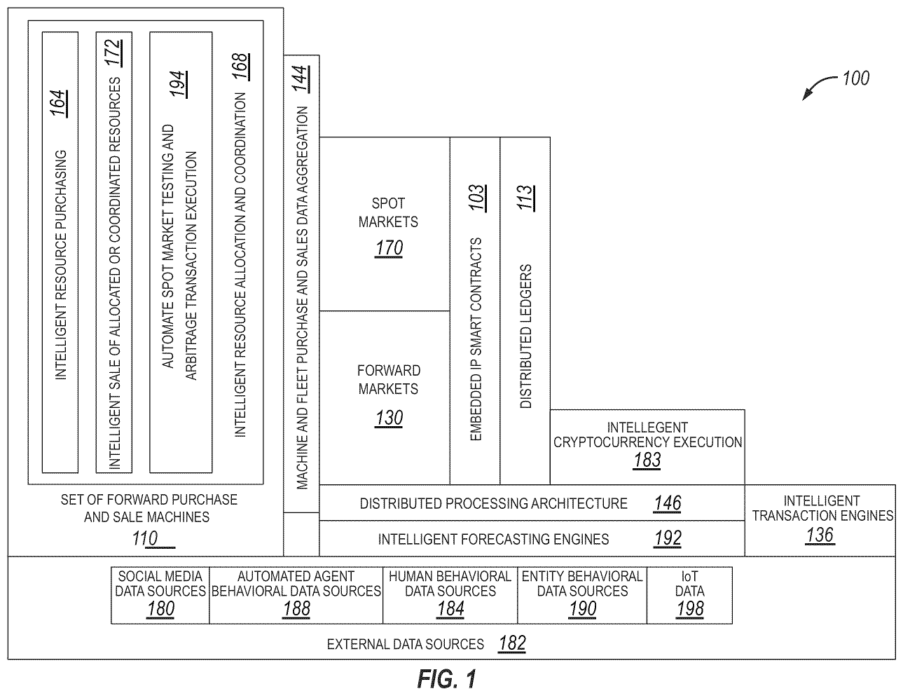

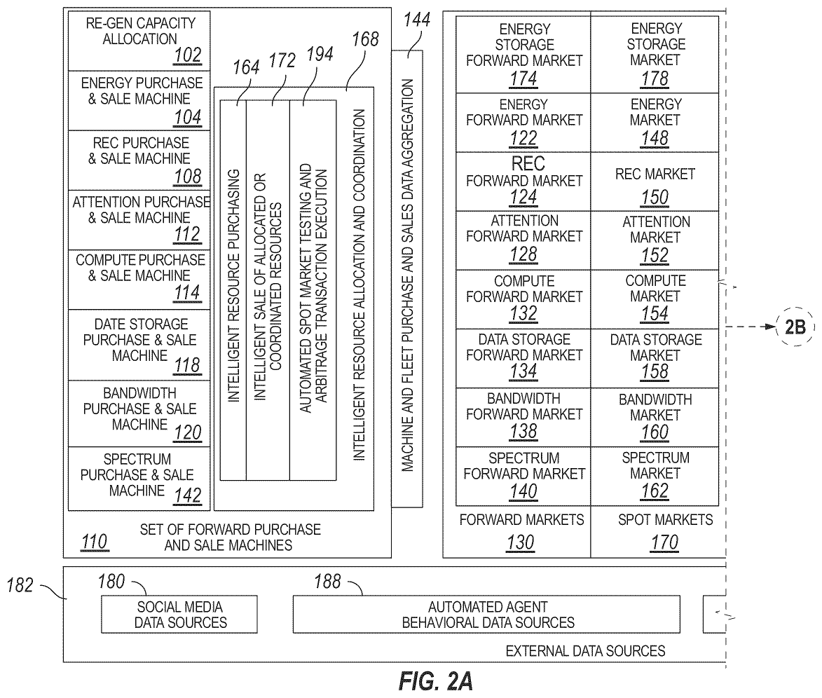

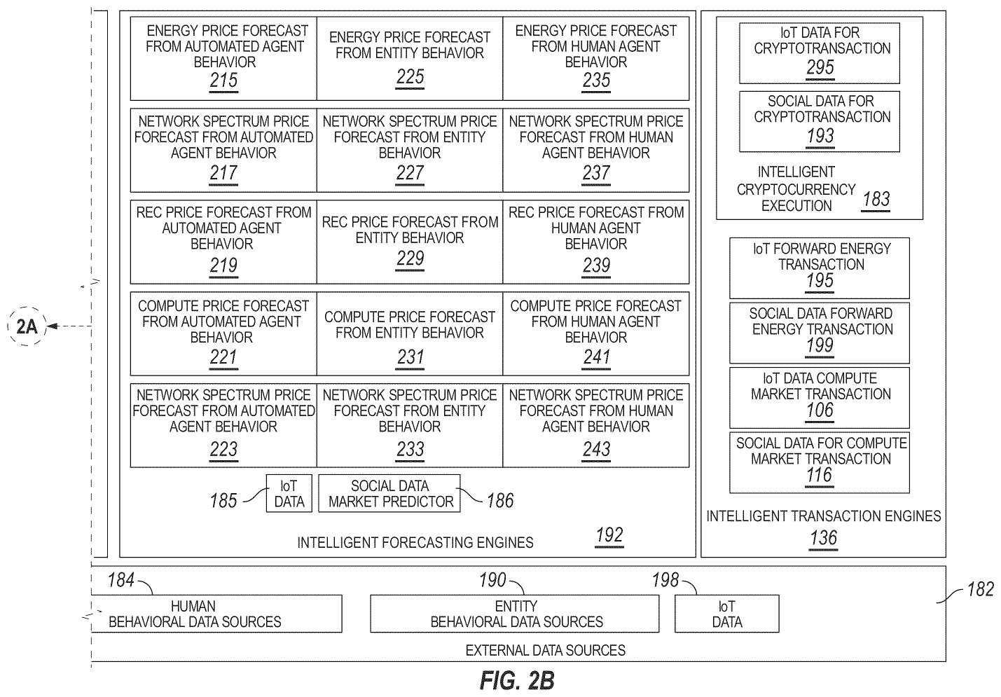

Referring to FIGS. 1, 2A and 2B, a set of systems, methods, components, modules, machines, articles, blocks, circuits, services, programs, applications, hardware, software and other elements are provided, collectively referred to herein interchangeably as the system 100 or the platform 100, The platform 100 enables a wide range of improvements of and for various machines, systems, and other components that enable transactions involving the exchange of value (such as using currency, cryptocurrency, tokens, rewards or the like, as well as a wide range of in-kind and other resources) in various markets, including current or spot markets 170, forward markets 130 and the like, for various goods, services, and resources. As used herein, “currency” should be understood to encompass fiat currency issued or regulated by governments, cryptocurrencies, tokens of value, tickets, loyalty points, rewards points, coupons, and other elements that represent or may be exchanged for value. Resources, such as ones that may be exchanged for value in a marketplace, should be understood to encompass goods, services, natural resources, energy resources, computing resources, energy storage resources, data storage resources, network bandwidth resources, processing resources and the like, including resources for which value is exchanged and resources that enable a transaction to occur (such as necessary computing and processing resources, storage resources, network resources, and energy resources that enable a transaction). The platform 100 may include a set of forward purchase and sale machines 110, each of which may be configured as an expert system or automated intelligent agent for interaction with one or more of the set of spot markets 170 and forward markets 130. Enabling the set of forward purchase and sale machines 110 are an intelligent resource purchasing system 164 having a set of intelligent agents for purchasing resources in spot and forward markets; an intelligent resource allocation and coordination system 168 for the intelligent sale of allocated or coordinated resources, such as compute resources, energy resources, and other resources involved in or enabling a transaction; an intelligent sale engine 172 for intelligent coordination of a sale of allocated resources in spot and futures markets; and an automated spot market testing and arbitrage transaction execution engine 194 for performing spot testing of spot and forward markets, such as with micro-transactions and, where conditions indicate favorable arbitrage conditions, automatically executing transactions in resources that take advantage of the favorable conditions. Each of the engines may use model-based or rule-based expert systems, such as based on rules or heuristics, as well as deep learning systems by which rules or heuristics may be learned over trials involving a large set of inputs. The engines may use any of the expert systems and artificial intelligence capabilities described throughout this disclosure. Interactions within the platform 100, including of all platform components, and of interactions among them and with various markets, may be tracked and collected, such as by a data aggregation system 144, such as for aggregating data on purchases and sales in various marketplaces by the set of machines described herein. Aggregated data may include tracking and outcome data that may be fed to artificial intelligence and machine learning systems, such as to train or supervise the same. The various engines may operate on a range of data sources, including aggregated data from marketplace transactions, tracking data regarding the behavior of each of the engines, and a set of external data sources 182, which may include social media data sources 180 (such as social networking sites like Facebook™ and Twitter™), Internet of Things (IoT) data sources (including from sensors, cameras, data collectors, and instrumented machines and systems), such as IoT sources that provide information about machines and systems that enable transactions and machines and systems that are involved in production and consumption of resources. External data sources 182 may include behavioral data sources, such as automated agent behavioral data sources 188 (such as tracking and reporting on behavior of automated agents that are used for conversation and dialog management, agents used for control functions for machines and systems, agents used for purchasing and sales, agents used for data collection, agents used for advertising, and others), human behavioral data sources (such as data sources tracking online behavior, mobility behavior, energy consumption behavior, energy production behavior, network utilization behavior, compute and processing behavior, resource consumption behavior, resource production behavior, purchasing behavior, attention behavior, social behavior, and others), and entity behavioral data sources 190 (such as behavior of business organizations and other entities, such as purchasing behavior, consumption behavior, production behavior, market activity, merger and acquisition behavior, transaction behavior, location behavior, and others). The IoT, social and behavioral data from and about sensors, machines, humans, entities, and automated agents may collectively be used to populate expert systems, machine learning systems, and other intelligent systems and engines described throughout this disclosure, such as being provided as inputs to deep learning systems and being provided as feedback or outcomes for purposes of training, supervision, and iterative improvement of systems for prediction, forecasting, classification, automation and control. The data may be organized as a stream of events. The data may be stored in a distributed ledger or other distributed system. The data may be stored in a knowledge graph where nodes represent entities and links represent relationships. The external data sources may be queried via various database query functions. The external data sources 182 may be accessed via APIs, brokers, connectors, protocols like REST and SOAP, and other data ingestion and extraction techniques. Data may be enriched with metadata and may be subject to transformation and loading into suitable forms for consumption by the engines, such as by cleansing, normalization, de-duplication, and the like.

The platform 100 may include a set of intelligent forecasting engines 192 for forecasting events, activities, variables, and parameters of spot markets 170, forward markets 130, resources that are traded in such markets, resources that enable such markets, behaviors (such as any of those tracked in the external data sources 182), transactions, and the like. The intelligent forecasting engines 192 may operate on data from the data aggregation systems 144 about elements of the platform 100 and on data from the external data sources 182. The platform may include a set of intelligent transaction engines 136 for automatically executing transactions in spot markets 170 and forward markets 130. This may include executing intelligent cryptocurrency transactions with an intelligent cryptocurrency execution engine 183 as described in more detail below. The platform 100 may make use of asset of improved distributed ledgers 113 and improved smart contracts 103, including ones that embed and operate on proprietary information, instruction sets and the like that enable complex transactions to occur among individuals with reduced (or without) reliance on intermediaries. These and other components are described in more detail throughout this disclosure.

Referring to the block diagrams of FIGS. 2A and 2B, further details and additional components of the platform 100 and interactions among them are depicted. The set of forward purchase and sale machines 110 may include a regeneration capacity allocation engine 102 (such as for allocating energy generation or regeneration capacity, such as within a hybrid vehicle or system that includes energy generation or regeneration capacity, a renewable energy system that has energy storage, or other energy storage system, where energy is allocated for one or more of sale on a forward market 130, sale in a spot market 170, use in completing a transaction (e.g., mining for cryptocurrency), or other purposes. For example, the regeneration capacity allocation engine 102 may explore available options for use of stored energy, such as sale in current and forward energy markets that accept energy from producers, keeping the energy in storage for future use, or using the energy for work (which may include processing work, such as processing activities of the platform like data collection or processing, or processing work for executing transactions, including mining activities for cryptocurrencies).

The set of forward purchase and sale machines 110 may include an energy purchase and sale machine 104 for purchasing or selling energy, such as in an energy spot market 148 or an energy forward market 122. The energy purchase and sale machine 104 may use an expert system, neural network or other intelligence to determine timing of purchases, such as based on current and anticipated state information with respect to pricing and availability of energy and based on current and anticipated state information with respect to needs for energy, including needs for energy to perform computing tasks, cryptocurrency mining, data collection actions, and other work, such as work done by automated agents and systems and work required for humans or entities based on their behavior. For example, the energy purchase machine may recognize, by machine learning, that a business is likely to require a block of energy in order to perform an increased level of manufacturing based on an increase in orders or market demand and may purchase the energy at a favorable price on a futures market, based on a combination of energy market data and entity behavioral data. Continuing the example, market demand may be understood by machine learning, such as by processing human behavioral data sources 184, such as social media posts, e-commerce data and the like that indicate increasing demand. The energy purchase and sale machine 104 may sell energy in the energy spot market 148 or the energy forward market 122. Sale may also be conducted by an expert system operating on the various data sources described herein, including with training on outcomes and human supervision.

The set of forward purchase and sale machines 110 may include a renewable energy credit (REC) purchase and sale machine 108, which may purchase renewable energy credits, pollution credits, and other environmental or regulatory credits in a spot market 150 or forward market 124 for such credits. Purchasing may be configured and managed by an expert system operating on any of the external data sources 182 or on data aggregated by the set of data aggregation systems 144 for the platform. Renewable energy credits and other credits may be purchased by an automated system using an expert system, including machine learning or other artificial intelligence, such as where credits are purchased with favorable timing based on an understanding of supply and demand that is determined by processing inputs from the data sources. The expert system may be trained on a data set of outcomes from purchases under historical input conditions. The expert system may be trained on a data set of human purchase decisions and/or may be supervised by one or more human operators. The renewable energy credit (REC) purchase and sale machine 108 may also sell renewable energy credits, pollution credits, and other environmental or regulatory credits in a spot market 150 or forward market 124 for such credits. Sale may also be conducted by an expert system operating on the various data sources described herein, including with training on outcomes and human supervision.

The set of forward purchase and sale machines 110 may include an attention purchase and sale machine 112, which may purchase one or more attention-related resources, such as advertising space, search listing, keyword listing, banner advertisements, participation in a panel or survey activity, participation in a trial or pilot, or the like in a spot market for attention 152 or a forward market for attention 128. Attention resources may include the attention of automated agents, such as bots, crawlers, dialog managers, and the like that are used for searching, shopping, and purchasing. Purchasing of attention resources may be configured and managed by an expert system operating on any of the external data sources 182 or on data aggregated by the set of data aggregation systems 144 for the platform. Attention resources may be purchased by an automated system using an expert system, including machine learning or other artificial intelligence, such as where resources are purchased with favorable timing, such as based on an understanding of supply and demand, that is determined by processing inputs from the various data sources. For example, the attention purchase and sale machine 112 may purchase advertising space in a forward market for advertising based on learning from a wide range of inputs about market conditions, behavior data, and data regarding activities of agent and systems within the platform 100. The expert system may be trained on a data set of outcomes from purchases under historical input conditions. The expert system may be trained on a data set of human purchase decisions and/or may be supervised by one or more human operators. The attention purchase and sale machine 112 may also sell one or more attention-related resources, such as advertising space, search listing, keyword listing, banner advertisements, participation in a panel or survey activity, participation in a trial or pilot, or the like in a spot market for attention 152 or a forward market for attention 128, which may include offering or selling access to, or attention or, one or more automated agents of the platform 100. Sale may also be conducted by an expert system operating on the various data sources described herein, including with training on outcomes and human supervision.

The set of forward purchase and sale machines 110 may include a compute purchase and sale machine 114, which may purchase one or more computation-related resources, such as processing resources, database resources, computation resources, server resources, disk resources, input/output resources, temporary storage resources, memory resources, virtual machine resources, container resources, and others in a spot market for compute 154 or a forward market for compute 132. Purchasing of compute resources may be configured and managed by an expert system operating on any of the external data sources 182 or on data aggregated by the set of data aggregation systems 144 for the platform. Compute resources may be purchased by an automated system using an expert system, including machine learning or other artificial intelligence, such as where resources are purchased with favorable timing, such as based on an understanding of supply and demand, that is determined by processing inputs from the various data sources. For example, the compute purchase and sale machine 114 may purchase or reserve compute resources on a cloud platform in a forward market for compute resources based on learning from a wide range of inputs about market conditions, behavior data, and data regarding activities of agent and systems within the platform 100, such as to obtain such resources at favorable prices during surge periods of demand for computing. The expert system may be trained on a data set of outcomes from purchases under historical input conditions. The expert system may be trained on a data set of human purchase decisions and/or may be supervised by one or more human operators. The compute purchase and sale machine 114 may also sell one or more computation-related resources that are connected to, part of, or managed by the platform 100, such as processing resources, database resources, computation resources, server resources, disk resources, input/output resources, temporary storage resources, memory resources, virtual machine resources, container resources, and others in a spot market for compute 154 or a forward market for compute 132. Sale may also be conducted by an expert system operating on the various data sources described herein, including with training on outcomes and human supervision.

The set of forward purchase and sale machines 110 may include a data storage purchase and sale machine 118, which may purchase one or more data-related resources, such as database resources, disk resources, server resources, memory resources, RAM resources, network attached storage resources, storage attached network (SAN) resources, tape resources, time-based data access resources, virtual machine resources, container resources, and others in a spot market for storage resources 158 or a forward market for data storage 134. Purchasing of data storage resources may be configured and managed by an expert system operating on any of the external data sources 182 or on data aggregated by the set of data aggregation systems 144 for the platform. Data storage resources may be purchased by an automated system using an expert system, including machine learning or other artificial intelligence, such as where resources are purchased with favorable timing, such as based on an understanding of supply and demand, that is determined by processing inputs from the various data sources. For example, the compute purchase and sale machine 114 may purchase or reserve compute resources on a cloud platform in a forward market for compute resources based on learning from a wide range of inputs about market conditions, behavior data, and data regarding activities of agent and systems within the platform 100, such as to obtain such resources at favorable prices during surge periods of demand for storage. The expert system may be trained on a data set of outcomes from purchases under historical input conditions. The expert system may be trained on a data set of human purchase decisions and/or may be supervised by one or more human operators. The data storage purchase and sale machine 118 may also sell one or more data storage-related resources that are connected to, part of, or managed by the platform 100 in a spot market for storage resources 158 or a forward market for data storage 134. Sale may also be conducted by an expert system operating on the various data sources described herein, including with training on outcomes and human supervision.

The set of forward purchase and sale machines 110 may include a bandwidth purchase and sale machine 120, which may purchase one or more bandwidth-related resources, such as cellular bandwidth, Wi-Fi bandwidth, radio bandwidth, access point bandwidth, beacon bandwidth, local area network bandwidth, wide area network bandwidth, enterprise network bandwidth, server bandwidth, storage input/output bandwidth, advertising network bandwidth, market bandwidth, or other bandwidth, in a spot market for bandwidth resources 160 or a forward market for bandwidth 138. Purchasing of bandwidth resources may be configured and managed by an expert system operating on any of the external data sources 182 or on data aggregated by the set of data aggregation systems 144 for the platform. Bandwidth resources may be purchased by an automated system using an expert system, including machine learning or other artificial intelligence, such as where resources are purchased with favorable timing, such as based on an understanding of supply and demand, that is determined by processing inputs from the various data sources. For example, the bandwidth purchase and sale machine 120 may purchase or reserve bandwidth on a network resource for a future networking activity managed by the platform based on learning from a wide range of inputs about market conditions, behavior data, and data regarding activities of agent and systems within the platform 100, such as to obtain such resources at favorable prices during surge periods of demand for bandwidth. The expert system may be trained on a data set of outcomes from purchases under historical input conditions. The expert system may be trained on a data set of human purchase decisions and/or may be supervised by one or more human operators. The bandwidth purchase and sale machine 120 may also sell one or more bandwidth-related resources that are connected to, part of, or managed by the platform 100 in a spot market for bandwidth resources 160 or a forward market for bandwidth 138. Sale may also be conducted by an expert system operating on the various data sources described herein, including with training on outcomes and human supervision.

The set of forward purchase and sale machines 110 may include a spectrum purchase and sale machine 142, which may purchase one or more spectrum-related resources, such as cellular spectrum, 3G spectrum, 4G spectrum, LTE spectrum, 5G spectrum, cognitive radio spectrum, peer-to-peer network spectrum, emergency responder spectrum and the like in a spot market for spectrum resources 162 or a forward market for spectrum/bandwidth 140. Purchasing of spectrum resources may be configured and managed by an expert system operating on any of the external data sources 182 or on data aggregated by the set of data aggregation systems 144 for the platform. Spectrum resources may be purchased by an automated system using an expert system, including machine learning or other artificial intelligence, such as where resources are purchased with favorable timing, such as based on an understanding of supply and demand, that is determined by processing inputs from the various data sources. For example, the spectrum purchase and sale machine 142 may purchase or reserve spectrum on a network resource for a future networking activity managed by the platform based on learning from a wide range of inputs about market conditions, behavior data, and data regarding activities of agent and systems within the platform 100, such as to obtain such resources at favorable prices during surge periods of demand for spectrum. The expert system may be trained on a data set of outcomes from purchases under historical input conditions. The expert system may be trained on a data set of human purchase decisions and/or may be supervised by one or more human operators. The spectrum purchase and sale machine 142 may also sell one or more spectrum-related resources that are connected to, part of, or managed by the platform 100 in a spot market for spectrum resources 162 or a forward market for spectrum/bandwidth 140. Sale may also be conducted by an expert system operating on the various data sources described herein, including with training on outcomes and human supervision.

In embodiments, the intelligent resource allocation and coordination system 168, including the intelligent resource purchasing system 164, the intelligent sale engine 172 and the automated spot market testing and arbitrage transaction execution engine 194, may provide coordinated and automated allocation of resources and coordinated execution of transactions across the various forward markets 130 and spot markets 170 by coordinating the various purchase and sale machines, such as by an expert system, such as a machine learning system (which may model-based or a deep learning system, and which may be trained on outcomes and/or supervised by humans). For example, the intelligent resource allocation and coordination system 168 may coordinate purchasing of resources for a set of assets and coordinated sale of resources available from a set of assets, such as a fleet of vehicles, a data center of processing and data storage resources, an information technology network (on premises, cloud, or hybrids), a fleet of energy production systems (renewable or non-renewable), a smart home or building (including appliances, machines, infrastructure components and systems, and the like thereof that consume or produce resources), and the like. The platform 100 may optimize allocation of resource purchasing, sale and utilization based on data aggregated in the platform, such as by tracking activities of various engines and agents, as well as by taking inputs from external data sources 182. In embodiments, outcomes may be provided as feedback for training the intelligent resource allocation and coordination system 168, such as outcomes based on yield, profitability, optimization of resources, optimization of business objectives, satisfaction of goals, satisfaction of users or operators, or the like. For example, as the energy for computational tasks becomes a significant fraction of an enterprise's energy usage, the platform 100 may learn to optimize how a set of machines that have energy storage capacity allocate that capacity among computing tasks (such as for cryptocurrency mining, application of neural networks, computation on data and the like), other useful tasks (that may yield profits or other benefits), storage for future use, or sale to the provider of an energy grid. The platform 100 may be used by fleet operators, enterprises, governments, municipalities, military units, first responder units, manufacturers, energy producers, cloud platform providers, and other enterprises and operators that own or operate resources that consume or provide energy, computation, data storage, bandwidth, or spectrum. The platform 100 may also be used in connection with markets for attention, such as to use available capacity of resources to support attention-based exchanges of value, such as in advertising markets, micro-transaction markets, and others.

Referring still to FIGS. 2A and 2B, the platform 100 may include a set of intelligent forecasting engines 192 that forecast one or more attributes, parameters, variables, or other factors, such as for use as inputs by the set of forward purchase and sale machines, the intelligent transaction engines 126 (such as for intelligent cryptocurrency execution) or for other purposes. Each of the set of intelligent forecasting engines 192 may use data that is tracked, aggregated, processed, or handled within the platform 100, such as by the data aggregation system 144, as well as input data from external data sources 182, such as social media data sources 180, automated agent behavioral data sources 188, human behavioral data sources 184, entity behavioral data sources 190 and IoT data sources 198. These collective inputs may be used to forecast attributes, such as using a model (e.g., Bayesian, regression, or other statistical model), a rule, or an expert system, such as a machine learning system that has one or more classifiers, pattern recognizers, and predictors, such as any of the expert systems described throughout this disclosure. In embodiments, the set of intelligent forecasting engines 192 may include one or more specialized engines that forecast market attributes, such as capacity, demand, supply, and prices, using particular data sources for particular markets. These may include an energy price forecasting engine 215 that bases its forecast on behavior of an automated agent, a network spectrum price forecasting engine 217 that bases its forecast on behavior of an automated agent, a REC price forecasting engine 219 that bases its forecast on behavior of an automated agent, a compute price forecasting engine 221 that bases its forecast on behavior of an automated agent, a network spectrum price forecasting engine 223 that bases its forecast on behavior of an automated agent. In each case, observations regarding the behavior of automated agents, such as ones used for conversation, for dialog management, for managing electronic commerce, for managing advertising and others may be provided as inputs for forecasting to the engines. The intelligent forecasting engines 192 may also include a range of engines that provide forecasts at least in part based on entity behavior, such as behavior of business and other organizations, such as marketing behavior, sales behavior, product offering behavior, advertising behavior, purchasing behavior, transactional behavior, merger and acquisition behavior, and other entity behavior. These may include an energy price forecasting engine 225 using entity behavior, a network spectrum price forecasting engine 227 using entity behavior, a REC price forecasting engine 229 using entity behavior, a compute price forecasting engine 231 using entity behavior, and a network spectrum price forecasting engine 233 using entity behavior.

The intelligent forecasting engines 192 may also include a range of engines that provide forecasts at least in part based on human behavior, such as behavior of consumers and users, such as purchasing behavior, shopping behavior, sales behavior, product interaction behavior, energy utilization behavior, mobility behavior, activity level behavior, activity type behavior, transactional behavior, and other human behavior. These may include an energy price forecasting engine 235 using human behavior, a network spectrum price forecasting engine 237 using human behavior, a REC price forecasting engine 239 using human behavior, a compute price forecasting engine 241 using human behavior, and a network spectrum price forecasting engine 243 using human behavior.

Referring still to FIGS. 2A and 2B, the platform 100 may include a set of intelligent transaction engines 136 that automate execution of transactions in forward markets 130 and/or spot markets 170 based on determination that favorable conditions exist, such as by the intelligent resource allocation and coordination system 168 and/or with use of forecasts form the intelligent forecasting engines 192. The intelligent transaction engines 136 may be configured to automatically execute transactions, using available market interfaces, such as APIs, connectors, ports, network interfaces, and the like, in each of the markets noted above. In embodiments, the intelligent transaction engines may execute transactions based on event streams that come from external data sources, such as IoT data sources 198 and social media data sources 180. The engines may include, for example, an IoT forward energy transaction engine 195 and/or an IoT compute market transaction engine 106, either or both of which may use data from the Internet of Things to determine timing and other attributes for market transaction in a market for one or more of the resources described herein, such as an energy market transaction, a compute resource transaction or other resource transaction. IoT data may include instrumentation and controls data for one or more machines (optionally coordinated as a fleet) that use or produce energy or that use or have compute resources, weather data that influences energy prices or consumption (such as wind data influencing production of wind energy), sensor data from energy production environments, sensor data from points of use for energy or compute resources (such as vehicle traffic data, network traffic data, IT network utilization data, Internet utilization and traffic data, camera data from work sites, smart building data, smart home data, and the like), and other data collected by or transferred within the Internet of Things, including data stored in IoT platforms and of cloud services providers like Amazon, IBM, and others. The intelligent transaction engines 136 may include engines that use social data to determine timing of other attributes for a market transaction in one or more of the resources described herein, such as a social data forward energy transaction engine 199 and/or a social data compute market transaction engine 116. Social data may include data from social networking sites (e.g., Facebook™, YouTube™, Twitter™, Snapchat™, Instagram™, and others), data from websites, data from e-commerce sites, and data from other sites that contain information that may be relevant to determining or forecasting behavior of users or entities, such as data indicating interest or attention to particular topics, goods or services, data indicating activity types and levels such as may be observed by machine processing of image data showing individuals engaged in activities, including travel, work activities, leisure activities, and the like. Social data may be supplied to machine learning, such as for learning user behavior or entity behavior, and/or as an input to an expert system, a model, or the like, such as one for determining, based on the social data, the parameters for a transaction. For example, an event or set of events in a social data stream may indicate the likelihood of a surge of interest in an online resource, a product, or a service, and compute resources, bandwidth, storage, or like may be purchased in advance (avoiding surge pricing) to accommodate the increased interest reflected by the social data stream.

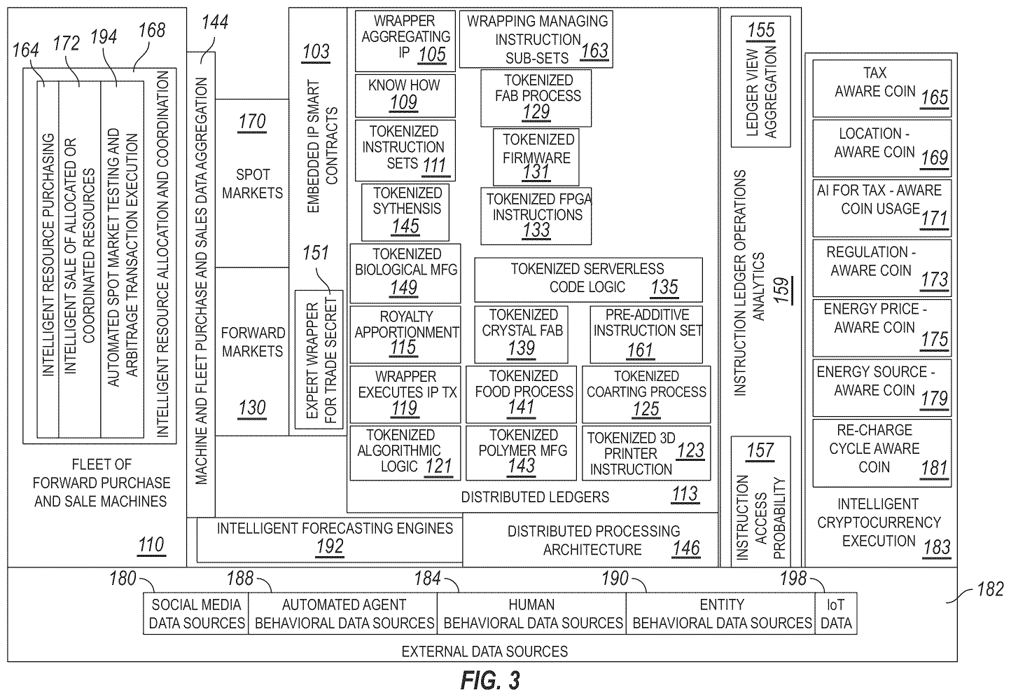

Referring to FIG. 3, the platform 100 may include capabilities for transaction execution that involve one or more distributed ledgers 113 and one or more smart contracts 103, where the distributed ledgers 113 and smart contracts 103 are configured to enable specialized transaction features for specific transaction domains. One such domain is intellectual property, which transactions are highly complex, involving licensing terms and conditions that are somewhat difficult to manage, as compared to more straightforward sales of goods or services. In embodiments, a smart contract wrapper 105, such as wrapper aggregating intellectual property, is provided, using a distributed ledger, wherein the smart contract embeds IP licensing terms for intellectual property that is embedded in the distributed ledger and wherein executing an operation on the distributed ledger provides access to the intellectual property and commits the executing party to the IP licensing terms. Licensing terms for a wide range of goods and services, including digital goods like video, audio, video game, video game element, music, electronic book, and other digital goods may be managed by tracking transactions involving them on a distributed ledger, whereby publishers may verify a chain of licensing and sublicensing. The distributed ledger may be configured to add each licensee to the ledger, and the ledger may be retrieved at the point of use of a digital item, such as in a streaming platform, to validate that licensing has occurred.

In embodiments, an improved distributed ledger is provided with the smart contract wrapper 105, such as an IP wrapper, container, smart contract, or similar mechanism for aggregating intellectual property licensing terms, wherein a smart contract wrapper on the distributed ledger allows an operation on the ledger to add intellectual property to an aggregate stack of intellectual property. In many cases, intellectual property builds on other intellectual property, such as where software code is derived from other code, where trade secrets or know-how for elements of a process are combined to enable a larger process, where patents covering sub-components of a system or steps in a process are pooled, where elements of a video game include sub-component assets from different creators, where a book contains contributions from multiple authors, and the like. In embodiments, a smart IP wrapper aggregates licensing terms for different intellectual property items (including digital goods, including ones embodying different types of intellectual property rights, and transaction data involving the item, as well as optionally one or more portions of the item corresponding to the transaction data, are stored in a distributed ledger that is configured to enable validation of agreement to the licensing terms (such as at appoint of use) and/or access control to the item. In embodiments, a royalty apportionment wrapper 115 may be provided in a system having a distributed ledger for aggregating intellectual property licensing terms, wherein a smart contract wrapper on the distributed ledger allows an operation on the ledger to add intellectual property and to agree to an apportionment of royalties among the parties in the ledger. Thus, a ledger may accumulate contributions to the ledger along with evidence of agreement to the apportionment of any royalties among the contributors of the IP that is embedded in and/or controlled by the ledger. The ledger may record licensing terms and automatically vary them as new contributions are made, such as by one or more rules. For example, contributors may be given a share of a royalty stack according to a rule, such as based on a fractional contribution, such as based on lines of code contributed, lines of authorship, contribution to components of a system, and the like. In embodiments, a distributed ledger may be forked into versions that represent varying combinations of sub-components of IP, such as to allow users to select combinations that are of most use, thereby allowing contributors who have contributed the most value to be rewarded. Variation and outcome tracking may be iteratively improved, such as by machine learning.

In embodiments, a distributed ledger is provided for aggregating intellectual property licensing terms, wherein a smart contract wrapper on the distributed ledger allows an operation on the ledger to add intellectual property to an aggregate stack of intellectual property.

In embodiments, the platform 100 may have an improved distributed ledger for aggregating intellectual property licensing terms, wherein a smart contract wrapper on the distributed ledger allows an operation on the ledger to commit a party to a contract term via an IP transaction wrapper 119 of the ledger. This may include operations involving cryptocurrencies, tokens, or other operations, as well as conventional payments and in-kind transfers, such as of various resources described herein. The ledger may accumulate evidence of commitments to IP transactions by parties, such as entering into royalty terms, revenue sharing terms, IP ownership terms, warranty and liability terms, license permissions and restrictions, field of use terms, and many others.

In embodiments, improved distributed ledgers may include ones having a tokenized instruction set, such that operation on the distributed ledger provides provable access to the instruction set. A party wishing to share permission to know how, a trade secret or other valuable instructions may thus share the instruction set via a distributed ledger that captures and stores evidence of an action on the ledger by a third party, thereby evidencing access and agreement to terms and conditions of access. In embodiments, the platform 100 may have a distributed ledger that tokenizes executable algorithmic logic 121, such that operation on the distributed ledger provides provable access to the executable algorithmic logic. A variety of instruction sets may be stored by a distributed ledger, such as to verify access and verify agreement to terms (such as smart contract terms). In embodiments, instruction sets that embody trade secrets may be separated into sub-components, so that operations must occur on multiple ledgers to get (provable) access to a trade secret. This may permit parties wishing to share secrets, such as with multiple sub-contractors or vendors, to main provable access control, while separating components among different vendors to avoid sharing an entire set with a single party. Various kinds of executable instruction sets may be stored on specialized distributed ledgers that may include smart wrappers for specific types of instruction sets, such that provable access control, validation of terms, and tracking of utilization may be performed by operations on the distributed ledger (which may include triggering access controls within a content management system or other systems upon validation of actions taken in a smart contract on the ledger. In embodiments, the platform 100 may have a distributed ledger that tokenizes a 3D printer instruction set 123, such that operation on the distributed ledger provides provable access to the instruction set.

In embodiments, the platform 100 may have a distributed ledger that tokenizes an instruction set for a coating process 125, such that operation on the distributed ledger provides provable access to the instruction set.

In embodiments, the platform 100 may have a distributed ledger that tokenizes an instruction set for a semiconductor fabrication process 129, such that operation on the distributed ledger provides provable access to the fabrication process.

In embodiments, the platform 100 may have a distributed ledger that tokenizes a firmware program 131, such that operation on the distributed ledger provides provable access to the firmware program.

In embodiments, the platform 100 may have a distributed ledger that tokenizes an instruction set for an FPGA 133, such that operation on the distributed ledger provides provable access to the FPGA.

In embodiments, the platform 100 may have a distributed ledger that tokenizes serverless code logic 135, such that operation on the distributed ledger provides provable access to the serverless code logic.

In embodiments, the platform 100 may have a distributed ledger that tokenizes an instruction set for a crystal fabrication system 139, such that operation on the distributed ledger provides provable access to the instruction set.

In embodiments, the platform 100 may have a distributed ledger that tokenizes an instruction set for a food preparation process 141, such that operation on the distributed ledger provides provable access to the instruction set.

In embodiments, the platform 100 may have a distributed ledger that tokenizes an instruction set for a polymer production process 143, such that operation on the distributed ledger provides provable access to the instruction set.

In embodiments, the platform 100 may have a distributed ledger that tokenizes an instruction set for chemical synthesis process 145, such that operation on the distributed ledger provides provable access to the instruction set.

In embodiments, the platform 100 may have a distributed ledger that tokenizes an instruction set for a biological production process 149, such that operation on the distributed ledger provides provable access to the instruction set.

In embodiments, the platform 100 may have a distributed ledger that tokenizes a trade secret with an expert wrapper 151, such that operation on the distributed ledger provides provable access to the trade secret and the wrapper provides validation of the trade secret by the expert. An interface may be provided by which an expert accesses the trade secret on the ledger and verifies that the information is accurate and sufficient to allow a third party to use the secret.

In embodiments, the platform 100 may have a distributed ledger that aggregates views of a trade secret into a chain that proves which and how many parties have viewed the trade secret. Views may be used to allocate value to creators of the trade secret, to operators of the platform 100, or the like.

In embodiments, the platform 100 may have a distributed ledger that tokenizes an instruction set 111, such that operation on the distributed ledger provides provable access 155 to the instruction set and execution of the instruction set on a system results in recording a transaction in the distributed ledger.

In embodiments, the platform 100 may have a distributed ledger that tokenizes an item of intellectual property and a reporting system that reports an analytic result based on the operations performed on the distributed ledger or the intellectual property.

In embodiments, the platform 100 may have a distributed ledger that aggregates a set of instructions, where an operation on the distributed ledger adds at least one instruction to a pre-existing set of instructions 161 to provide a modified set of instructions.

Referring still to FIG. 3, an intelligent cryptocurrency execution engine 183 may provide intelligence for the timing, location, and other attributes of a cryptocurrency transaction, such as a mining transaction, an exchange transaction, a storage transaction, a retrieval transaction, or the like. Cryptocurrencies like Bitcoin™ are increasingly widespread, with specialized coins having emerged for a wide variety of purposes, such as exchanging value in various specialized market domains. Initial offerings of such coins, or ICOs, are increasingly subject to regulations, such as securities regulations, and in some cases to taxation. Thus, while cryptocurrency transactions typically occur within computer networks, jurisdictional factors may be important in determining where, when, and how to execute a transaction, store a cryptocurrency, exchange it for value. In embodiments, intelligent cryptocurrency execution engine 183 may use features embedded in or wrapped around the digital object representing a coin, such as features that cause the execution of transactions in the coin to be undertaken with awareness of various conditions, including geographic conditions, regulatory conditions, tax conditions, market conditions, and the like.

In embodiments, the platform 100 may include a tax aware coin 165 or smart wrapper for a cryptocurrency coin that directs execution of a transaction involving the coin to a geographic location based on tax treatment of at least one of the coin and the transaction in the geographic location.

In embodiments, the platform 100 may include a location-aware coin 169 or smart wrapper that enables a self-executing cryptocurrency coin that commits a transaction upon recognizing a location-based parameter that provides favorable tax treatment.

In embodiments, the platform 100 may include an expert system or AI agent 171 that uses machine learning to optimize the execution of cryptocurrency transactions based on tax status. Machine learning may use one or more models or heuristics, such as populated with relevant jurisdictional tax data, may be trained on a training set of human trading operations, may be supervised by human supervisors, and/or may use a deep learning technique based on outcomes over time, such as when operating on a wide range of internal system data and external data sources 182 as described throughout this disclosure.

In embodiments, the platform 100 may include regulation aware coin 173 having a coin, a smart wrapper, and/or an expert system that aggregates regulatory information covering cryptocurrency transactions and automatically selects a jurisdiction for an operation based on the regulatory information. Machine learning may use one or more models or heuristics, such as populated with relevant jurisdictional regulatory data, may be trained on a training set of human trading operations, may be supervised by human supervisors, and/or may use a deep learning technique based on outcomes over time, such as when operating on a wide range of internal system data and external data sources 182 as described throughout this disclosure.

In embodiments, the platform 100 may include an energy price-aware coin 175, wrapper, or expert system that uses machine learning to optimize the execution of a cryptocurrency transaction based on real time energy price information for an available energy source. Cryptocurrency transactions, such as coin mining and blockchain operations, may be highly energy intensive. An energy price-aware coin may be configured to time such operations based on energy price forecasts, such as with one or more of the intelligent forecasting engines 192 described throughout this disclosure.

In embodiments, the platform 100 may include an energy source aware coin 179, wrapper, or expert system that uses machine learning to optimize the execution of a cryptocurrency transaction based on an understanding of available energy sources to power computing resources to execute the transaction. For example, coin mining may be performed only when renewable energy sources are available. Machine learning for optimization of a transaction may use one or more models or heuristics, such as populated with relevant energy source data (such as may be captured in a knowledge graph, which may contain energy source information by type, location and operating parameters), may be trained on a training set of input-output data for human-initiated transactions, may be supervised by human supervisors, and/or may use a deep learning technique based on outcomes over time, such as when operating on a wide range of internal system data and external data sources 182 as described throughout this disclosure.

In embodiments, the platform 100 may include a charging cycle aware coin 181, wrapper, or an expert system that uses machine learning to optimize charging and recharging cycle of a rechargeable battery system to provide energy for execution of a cryptocurrency transaction. For example, a battery may be discharged for a cryptocurrency transaction only if a minimum threshold of battery charge is maintained for other operational use, if re-charging resources are known to be readily available, or the like. Machine learning for optimization of charging and recharging may use one or more models or heuristics, such as populated with relevant battery data (such as may be captured in a knowledge graph, which may contain energy source information by type, location and operating parameters), may be trained on a training set of human operations, may be supervised by human supervisors, and/or may use a deep learning technique based on outcomes over time, such as when operating on a wide range of internal system data and external data sources 182 as described throughout this disclosure.

Optimization of various intelligent coin operations may occur with machine learning that is trained on outcomes, such as financial profitability. Any of the machine learning systems described throughout this disclosure may be used for optimization of intelligent cryptocurrency transaction management.

In embodiments, compute resources, such as those mentioned throughout this disclosure, may be allocated to perform a range of computing tasks, both for operations that occur within the platform 100, ones that are managed by the platform, and ones that involve the activities, workflows and processes of various assets that may be owned, operated or managed in conjunction with the platform, such as sets or fleets of assets that have or use computing resources. Examples of compute tasks include, without limitation, cryptocurrency mining, distributed ledger calculations and storage, forecasting tasks, transaction execution tasks, spot market testing tasks, internal data collection tasks, external data collection, machine learning tasks, and others. As noted above, energy, compute resources, bandwidth, spectrum, and other resources may be coordinated, such as by machine learning, for these tasks. Outcome and feedback information may be provided for the machine learning, such as outcomes for any of the individual tasks and overall outcomes, such as yield and profitability for business or other operations involving the tasks.

In embodiments, networking resources, such as those mentioned throughout this disclosure, may be allocated to perform a range of networking tasks, both for operations that occur within the platform 100, ones that are managed by the platform, and ones that involve the activities, workflows and processes of various assets that may be owned, operated or managed in conjunction with the platform, such as sets or fleets of assets that have or use networking resources. Examples of networking tasks include cognitive network coordination, network coding, peer bandwidth sharing (including, for example cost-based routing, value-based routing, outcome-based routing, and the like), distributed transaction execution, spot market testing, randomization (e.g., using genetic programming with outcome feedback to vary network configurations and transmission paths), internal data collection and external data collection. As noted above, energy, compute resources, bandwidth, spectrum, and other resources may be coordinated, such as by machine learning, for these networking tasks. Outcome and feedback information may be provided for the machine learning, such as outcomes for any of the individual tasks and overall outcomes, such as yield and profitability for business or other operations involving the tasks.

In embodiments, data storage resources, such as those mentioned throughout this disclosure, may be allocated to perform a range of data storage tasks, both for operations that occur within the platform 100, ones that are managed by the platform, and ones that involve the activities, workflows and processes of various assets that may be owned, operated or managed in conjunction with the platform, such as sets or fleets of assets that have or use networking resources. Examples of data storage tasks include distributed ledger storage, storage of internal data (such as operational data with the platform), cryptocurrency storage, smart wrapper storage, storage of external data, storage of feedback and outcome data, and others. As noted above, data storage, energy, compute resources, bandwidth, spectrum, and other resources may be coordinated, such as by machine learning, for these data storage tasks. Outcome and feedback information may be provided for the machine learning, such as outcomes for any of the individual tasks and overall outcomes, such as yield and profitability for business or other operations involving the tasks.

In embodiments, smart contracts, such as ones embodying terms relating to intellectual property, trade secrets, know how, instruction sets, algorithmic logic, and the like may embody or include contract terms, which may include terms and conditions for options, royalty stacking terms, field exclusivity, partial exclusivity, pooling of intellectual property, standards terms (such as relating to essential and non-essential patent usage), technology transfer terms, consulting service terms, update terms, support terms, maintenance terms, derivative works terms, copying terms, and performance-related rights or metrics, among many others.

In embodiments, where an instruction set is embodied in digital form, such as contained in or managed by a distributed ledger transactions system, various systems may be configured with interfaces that allow them to access and use the instruction sets. In embodiments, such systems may include access control features that validate proper licensing by inspection of a distributed ledger, a key, a token, or the like that indicates the presence of access rights to an instruction set. Such systems that execute distributed instruction sets may include systems for 3D printing, crystal fabrication, semiconductor fabrication, coating items, producing polymers, chemical synthesis, and biological production, among others.

Networking capabilities and network resources should be understood to include a wide range of networking systems, components and capabilities, including infrastructure elements for 3G, 4G, LTE, 5G and other cellular network types, access points, routers, and other Wi-Fi elements, cognitive networking systems and components, mobile networking systems and components, physical layer, MAC layer and application layer systems and components, cognitive networking components and capabilities, peer-to-peer networking components and capabilities, optical networking components and capabilities, and others.

### Integrated Circuits

In embodiments, one or more of the controllers, circuits, systems, data collectors, storage systems, network elements, or the like as described throughout this disclosure may be embodied in or on an integrated circuit, such as an analog, digital, or mixed signal circuit, such as a microprocessor, a programmable logic controller, an application-specific integrated circuit, a field programmable gate array, or other circuits, such as embodied on one or more chips disposed on one or more circuit boards, such as to provide in hardware (with potentially accelerated speed, energy performance, input-output performance, or the like) one or more of the functions described herein. This may include setting up circuits with up to billions of logic gates, flip-flops, multiplexers, and other circuits in a small space, facilitating high speed processing, low power dissipation, and reduced manufacturing cost compared with board-level integration. In embodiments, a digital IC, typically a microprocessor, digital signal processor, microcontroller, or the like may use Boolean algebra to process digital signals to embody complex logic, such as involved in the circuits, controllers, and other systems described herein. In embodiments, a data collector, an expert system, a storage system, or the like may be embodied as a digital integrated circuit, such as a logic IC, memory chip, interface IC (e.g., a level shifter, a serializer, a deserializer, and the like), a power management IC and/or a programmable device; an analog integrated circuit, such as a linear IC, RF IC, or the like, or a mixed signal IC, such as a data acquisition IC (including A/D converters, D/A converter, digital potentiometers) and/or a clock/timing IC.

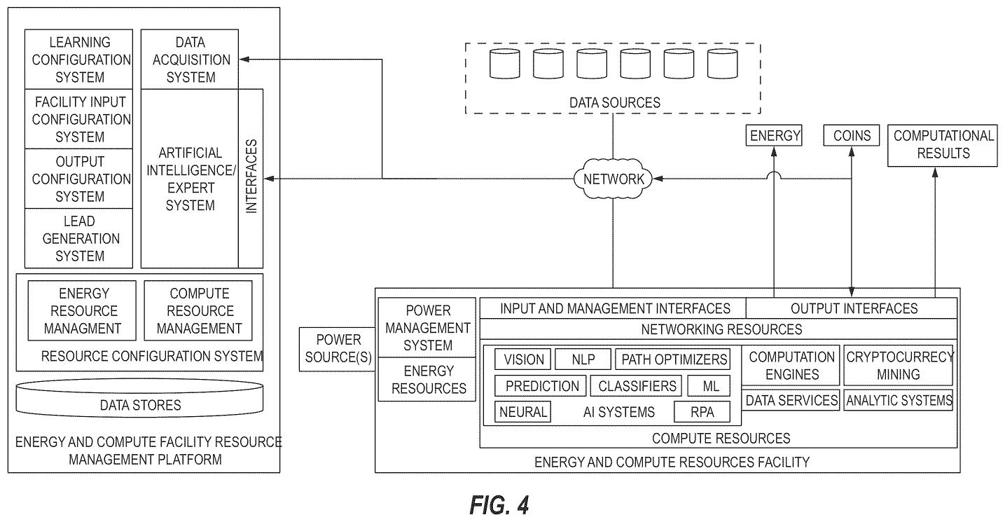

With reference to FIG. 4, the environment includes an intelligent energy and compute facility (such as a large scale facility hosting many compute resources and having access to a large energy source, such as a hydropower source), as well as a host intelligent energy and compute facility resource management platform, referred to in some cases for convenience as the energy and information technology platform (with networking, data storage, data processing and other resources as described herein), a set of data sources, a set of expert systems, interfaces to a set of market platforms and external resources, and a set of user (or client) systems and devices.

### Intelligent Energy and Compute Facility

A facility may be configured to access an inexpensive (at least during some time periods) power source (such as a hydropower dam, a wind farm, a solar array, a nuclear power plant, or a grid), to contain a large set of networked information technology resources, including processing units, servers, and the like that are capable of flexible utilization (such as by switching inputs, switching configurations, switching programming, and the like), and to provide a range of outputs that can also be flexibly configured (such as passing through power to a smart grid, providing computational results (such as for cryptocurrency mining, artificial intelligence, or analytics). A facility may include a power storage system, such as for large scale storage of available power.

### Intelligent Energy and Compute Facility Resource Management Platform

In operation, a user can access the energy and information technology platform to initiate and manage a set of activities that involve optimizing energy and computing resources among a diverse set of available tasks. Energy resources may include hydropower, nuclear power, wind power, solar power, grid power and the like, as well as energy storage resources, such as batteries, gravity power, and storage using thermal materials, such as molten salts. Computing resources may include GPUs, FPGAs, servers, chips, Asics, processors, data storage media, networking resources, and many others. Available tasks may include cryptocurrency hash processing, expert system processing, computer vision processing, NLP, path optimization, applications of models such as for analytics, etc.

In embodiments, the platform may include various subsystems that may be implemented as micro services, such that other subsystems of the system access the functionality of a subsystem providing a micro service via application programming interface API. In some embodiments, the various services that are provided by the subsystems may be deployed in bundles that are integrated, such as by a set of APIs. Each of the subsystems is described in greater detail below.

The External Data Sources can include any system or device that can provide data to the platform. Examples of data sources can include market data sources (e.g., for financial markets, commercial markets (including e-commerce), advertising markets, energy markets, telecommunication markets, and many others). The energy and computing resource platform accesses external data sources via a network (e.g., the Internet) in any suitable manner (e.g., crawlers, extract-transform-load (ETL) systems, gateways, brokers, application programming interfaces (APIs), spiders, distributed database queries, and the like).

A facility is a facility that has an energy resource (e.g., a hydro power resource) and a set of compute resource (e.g., a set of flexible computing resources that can be provisioned and managed to perform computing tasks, such as GPUs, FPGAs and many others, a set of flexible networking resources that can similarly be provisioned and managed, such as by adjusting network coding protocols and parameters), and the like.

User and client systems and devices can include any system or device that may consume one or more computing or energy resource made available by the energy and computing resource platform. Examples include cryptocurrency systems (e.g., for Bitcoin and other cryptocurrency mining operations), expert and artificial intelligence systems (such as neural networks and other systems, such as for computer vision, natural language processing, path determination and optimization, pattern recognition, deep learning, supervised learning, decision support, and many others), energy management systems (such as smart grid systems), and many others. User and client systems may include user devices, such as smartphones, tablet computer devices, laptop computing devices, personal computing devices, smart televisions, gaming consoles, and the like.

### Cognitive Processing Systems

Various cognitive processing systems may implement one or more of machine learning processes, artificial intelligence processes, analytics processes, natural language processing processes, and natural language generation processes. In an example, a cognitive processing system may include a machine learning system, an artificial intelligence (AI) system, an analytics system, a natural language processing system, and a natural language generation system.

### Machine Learning System

In embodiments, the machine learning system may train models, such as predictive models (e.g., various types of neural networks, regression based models, and other machine-learned models). In embodiments, training can be supervised, semi-supervised, or unsupervised. In embodiments, training can be done using training data, which may be collected or generated for training purposes.

A facility output model (or prediction model) may be a model that receive facility attributes and outputs one or more predictions regarding the production or other output of a facility. Examples of predictions may be the amount of energy a facility will produce, the amount of processing the facility will undertake, the amount of data a network will be able to transfer, the amount of data that can be stored, the price of a component, service or the like (such as supplied to or provided by a facility), a profit generated by accomplishing a given tasks, the cost entailed in performing an action, and the like. In each case, the machine learning system optionally trains a model based on training data. In embodiments, the machine learning system may receive vectors containing facility attributes (e.g., facility type, facility capability, objectives sought, constraints or rules that apply to utilization of resources or the facility, or the like), person attributes (e.g., role, components managed, and the like), and outcomes (e.g., energy produced, computing tasks completed, and financial results, among many others). Each vector corresponds to a respective outcome and the attributes of the respective facility and respective actions that led to the outcome. The machine learning system takes in the vectors and generates predictive model based thereon. In embodiments, the machine learning system may store the predictive models in the model datastore.

In embodiments, training can also be done based on feedback received by the system, which is also referred to as “reinforcement learning.” In embodiments, the machine learning system may receive a set of circumstances that led to a prediction (e.g., attributes of facility, attributes of a model, and the like) and an outcome related to the facility and may update the model according to the feedback.

In embodiments, training may be provided from a training data set that is created by observing actions of a set of humans, such as facility managers managing facilities that have various capabilities and that are involved in various contexts and situations. This may include use of robotic process automation to learn on a training data set of interactions of humans with interfaces, such as graphical user interfaces, of one or more computer programs, such as dashboards, control systems, and other systems that are used to manage an energy and compute management facility.

### Artificial Intelligence (AI) Systems

In embodiments, the AI system leverages the predictive models to make predictions regarding facilities. Examples of predictions include ones related to inputs to a facility (e.g., available energy, cost of energy, cost of compute resources, networking capacity and the like, as well as various market information, such as pricing information for end use markets), ones related to components or systems of a facility (including performance predictions, maintenance predictions, uptime/downtime predictions, capacity predictions and the like), ones related to functions or workflows of the facility (such as ones that involved conditions or states that may result in following one or more distinct possible paths within a workflow, a process, or the like), ones related to outputs of the facility, and others. In embodiments, the AI system receives a facility identifier. In response to the facility identifier, the AI system may retrieve attributes corresponding to the facility. In some embodiments, the AI system may obtain the facility attributes from a graph. Additionally or alternatively, the AI system may obtain the facility attributes from a facility record corresponding to the facility identifier, and the person attributes from a person record corresponding to the person identifier.

Examples of additional attributes that can be used to make predictions about a facility or a related process of system include: related facility information; owner goals (including financial goals); client goals; and many more additional or alternative attributes. In embodiments, the AI system may output scores for each possible prediction, where each prediction corresponds to a possible outcome. For example, in using a prediction model used to determine a likelihood that a hydroelectric source for a facility will produce 5 MW of power, the prediction model can output a score for a “will produce” outcome and a score for a “will not produce” outcome. The AI system may then select the outcome with the highest score as the prediction. Alternatively, the AI system may output the respective scores to a requesting system.

### Clustering Systems

In embodiments, a clustering system clusters records or entities based on attributes contained herein. For example, similar facilities, resources, people, clients, or the like may be clustered. The clustering system may implement any suitable clustering algorithm. For example, when clustering people records to identify a list of customer leads corresponding to resources that can be sold by a facility, the clustering system may implement k-nearest neighbors clustering, whereby the clustering system identifies k people records that most closely relate to the attributes defined for the facility. In another example, the clustering system may implement k-means clustering, such that the clustering system identifies k different clusters of people records, whereby the clustering system or another system selects items from the cluster.

### Analytics System

In embodiments, an analytics system may perform analytics relating to various aspects of the energy and computing resource platform. The analytics system may analyze certain communications to determine which configurations of a facility produce the greatest yield, what conditions tend to indicate potential faults or problems, and the like.

### Management Application Platform

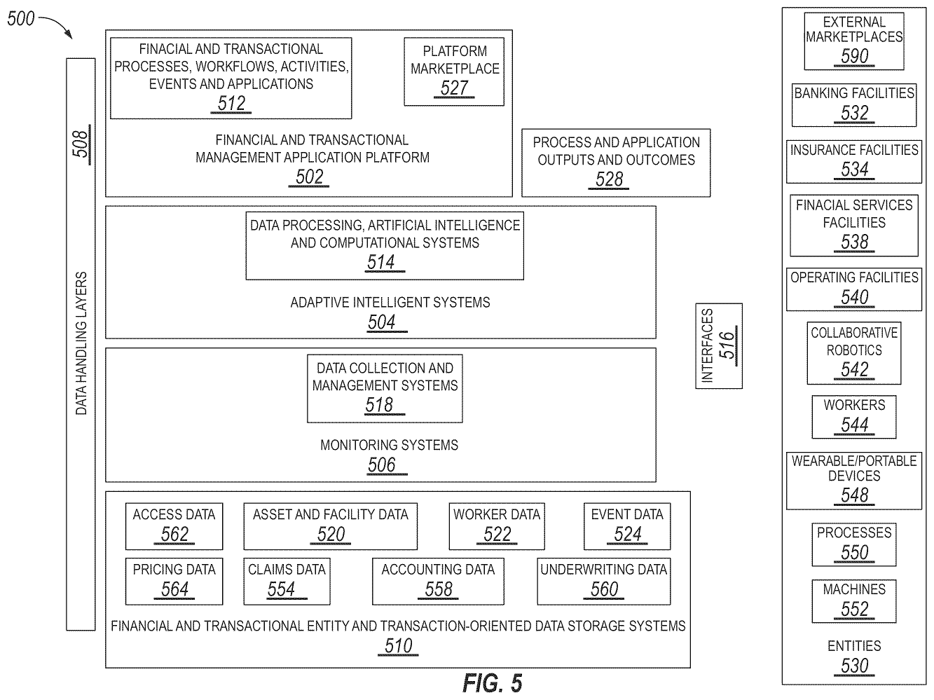

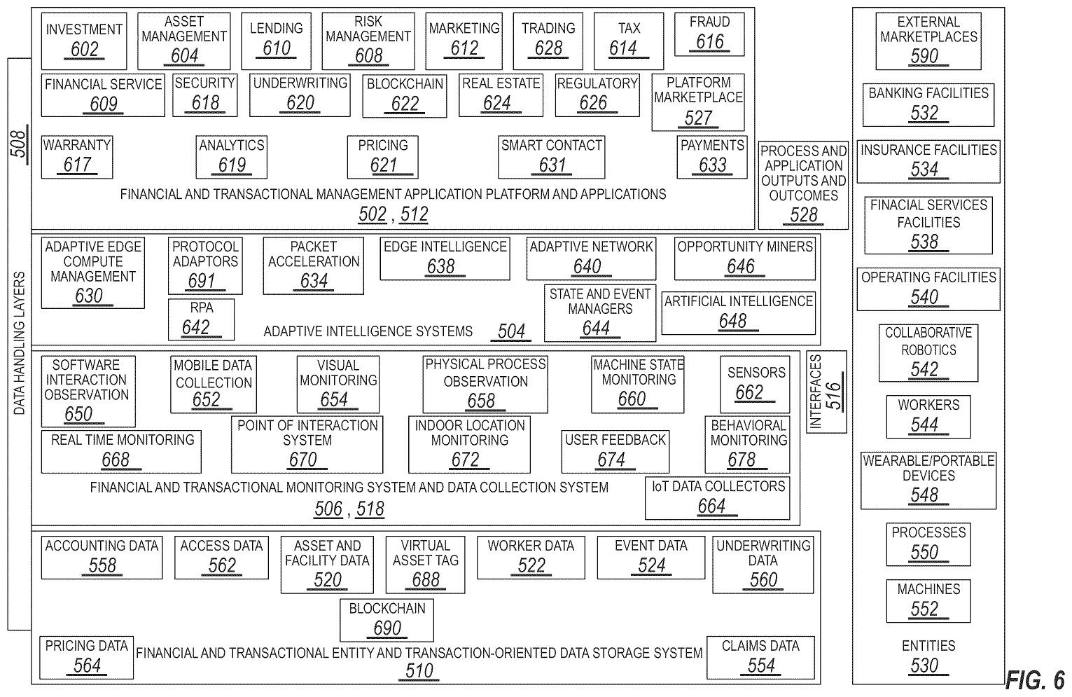

Referring to FIG. 5, a transactional, financial and marketplace enablement system 500 is illustrated, including a set of systems, applications, processes, modules, services, layers, devices, components, machines, products, sub-systems, interfaces, connections, and other elements working in coordination to enable intelligent management of a set of financial and transactional entities 530 that may occur, operate, transact or the like within, or own, operate, support or enable, one or more platform-operated marketplaces 527 or external marketplaces 590 or that may otherwise be part of, integrated with, linked to, or operated on by the platform 500. Platform-operated marketplaces 527 and external marketplaces 590 may include a wide variety of marketplaces and exchanges for physical goods, services, virtual goods, digital content, advertising, credits (such as renewable energy credits, pollution abatement credits and the like), currencies, commodities, cryptocurrencies, loyalty points, physical resources, human resources, attention resources, information technology resources, storage resources, energy resources, options, futures, derivatives, securities, rights of access, tickets, licenses (including seat licenses, private or government-issued licenses or permissions to undertake regulated activities, medallions, badges and others), and many others. Financial and transactional entities 530 may include any of the wide variety of assets, systems, devices, machines, facilities, individuals or other entities mentioned throughout this disclosure or in the documents incorporated herein by reference, such as, without limitation: financial machines 552 and their components (e.g., automated teller machines, point of sale machines, vending machines, kiosks, smart-card-enabled machines, and many others); financial and transactional processes 550 (such as lending processes, software processes (including applications, programs, services, and others), production processes, banking processes (e.g., lending processes, underwriting processes, investing processes, and many others), financial service processes, diagnostic processes, security processes, safety processes and many others); wearable and portable devices 548 (such as mobile phones, tablets, dedicated portable devices for financial applications, data collectors (including mobile data collectors), sensor-based devices, watches, glasses, hearables, head-worn devices, clothing-integrated devices, arm bands, bracelets, neck-worn devices, AR/VR devices, headphones, and many others); workers 544 (such as banking workers, financial service personnel, managers, engineers, floor managers, vault workers, inspectors, delivery personnel, currency handling workers, process supervisors, security personnel, safety personnel and many others); robotic systems 542 (e.g., physical robots, collaborative robots (e.g., “cobots”), software bots and others); and operating facilities 540 (such as currency production facilities, storage facilities, vaults, bank branches, office buildings, banking facilities, financial services facilities, cryptocurrency mining facilities, data centers, trading floors, high frequency trading operations, and many others), which may include, without limitation, among many others, storage and financial services facilities 538 (such as for financial services inventory, components, packaging materials, goods, products, machinery, equipment, and other items); insurance facilities 534 (such as branches, offices, storage facilities, data centers, underwriting operations and others); and banking facilities 532 (such as for commercial banking, investing, consumer banking, lending and many other banking activities).

In embodiments, the transactional, financial and marketplace enablement system 500 may include a set of data handling layers 508 each of which is configured to provide a set of capabilities that facilitate development and deployment of intelligence, such as for facilitating automation, machine learning, applications of artificial intelligence, intelligent transactions, state management, event management, process management, and many others, for a wide variety of financial and transactional applications and end uses. In embodiments, the data handling layers 508 include a financial and transactional monitoring systems layer 506, a financial and transactional entity-oriented data storage systems layer 510 (referred to in some cases herein for convenience simply as a data storage layer 510), an adaptive intelligent systems layer 504 and a financial and transactional management application platform layer 502. Each of the data handling layers 508 may include a variety of services, programs, applications, workflows, systems, components, and modules, as further described herein and in the documents incorporated herein by reference. In embodiments, each of the data handling layers 508 (and optionally the transactional, financial and marketplace enablement system 500 as a whole) is configured such that one or more of its elements can be accessed as a service by other layers 508 or by other systems (e.g., being configured as a platform-as-a-service deployed on a set of cloud infrastructure components in a microservices architecture). For example, a data handling layer 508 may have a set of application programming interfaces 516, such as application programming interfaces (APIs), brokers, services, connectors, wired or wireless communication links, ports, human-accessible interfaces, software interfaces or the like by which data may be exchanged between the data handling layer 508 and other layers, systems or sub-systems of the platform 500, as well as with other systems, such as financial entities 530 or external systems, such as cloud-based or on-premises enterprise systems (e.g., accounting systems, resource management systems, CRM systems, supply chain management systems and many others. Each of the data handling layers 508 may include a set of services (e.g., microservices), for data handling, including facilities for data extraction, transformation and loading; data cleansing and deduplication facilities; data normalization facilities; data synchronization facilities; data security facilities; computational facilities (e.g., for performing pre-defined calculation operations on data streams and providing an output stream); compression and de-compression facilities; analytic facilities (such as providing automated production of data visualizations) and others.

In embodiments, each data handling layer 508 has a set of application programming interfaces 516 for automating data exchange with each of the other data handling layers 508. These may include data integration capabilities, such as for extracting, transforming, loading, normalizing, compression, decompressing, encoding, decoding, and otherwise processing data packets, signals, and other information as it exchanged among the layers and/or the applications 512, such as transforming data from one format or protocol to another as needed in order for one layer to consume output from another. In embodiments, the data handling layers 508 are configured in a topology that facilitates shared data collection and distribution across multiple applications and uses within the transactional, financial and marketplace enablement system 500 by the financial and transactional monitoring systems layer 506. The financial and transactional monitoring systems layer 506 may include, integrate with, and/or cooperate with various data collection and management systems 518, referred to for convenience in some cases as data collection systems 518, for collecting and organizing data collected from or about financial and transactional entities 530, as well as data collected from or about the various data handling layers 508 or services or components thereof. For example, a stream of physiological data from a wearable device worn by a worker undertaking a task or a consumer engaged in an activity can be distributed via the monitoring systems layer 506 to multiple distinct applications in the financial and transactional management application platform layer 502, such as one that facilitates monitoring the physiological, psychological, performance level, attention, or other state of a worker and another that facilitates operational efficiency and/or effectiveness. In embodiments, the monitoring systems layer 506 facilitates alignment, such as time-synchronization, normalization, or the like of data that is collected with respect to one or more entities 530. For example, one or more video streams or other sensor data collected of or with respect to a worker 544 or other entity in a transactional or financial environment, such as from a set of camera-enabled IoT devices, may be aligned with a common clock, so that the relative timing of a set of videos or other data can be understood by systems that may process the videos, such as machine learning systems that operate on images in the videos, on changes between images in different frames of the video, or the like. In such an example, the financial and transactional monitoring systems layer 506 may further align a set of videos, camera images, sensor data, or the like, with other data, such as a stream of data from wearable devices, a stream of data produced by financial or transactional systems (such as point-of-sale systems, ATMs, kiosks, handheld transaction systems, card readers, and the like), a stream of data collected by mobile data collectors, and the like. Configuration of the financial and transactional monitoring systems layer 506 as a common platform, or set of microservices, that are accessed across many applications, may dramatically reduce the number of interconnections required by an enterprise in order to have a growing set of applications monitoring a growing set of IoT devices and other systems and devices that are under its control.

In embodiments, the data handling layers 508 are configured in a topology that facilitates shared or common data storage across multiple applications and uses of the transactional, financial and marketplace enablement system 500 by the financial and transactional entity and transaction-oriented data storage systems layer 510, referred to herein for convenience in some cases simply as the data storage layer 510 or storage layer 510. For example, various data collected about the financial entities 530, as well as data produced by the other data handling layers 508, may be stored in the data storage layer 510, such that any of the services, applications, programs, or the like of the various data handling layers 508 can access a common data source (which may comprise a single logical data source that is distributed across disparate physical and/or virtual storage locations). This may facilitate a dramatic reduction in the amount of data storage required to handle the enormous amount of data produced by or about entities 530 as applications of the financial and transactional IoT proliferate. For example, a supply chain or inventory management application in the financial and transactional management application platform layer 502, such as one for ordering replacement parts for a financial or transactional machine or item of equipment, or for reordering currency or other inventory, may access the same data set about what parts have been replaced for a set of machines as a predictive maintenance application that is used to predict whether a machine is likely to require replacement parts. Similarly, prediction may be used with respect to resupply of currency or other items. In embodiments, the data storage systems layer 510 may provide an extremely rich environment for collection of data that can be used for extraction of features or inputs for intelligence systems, such as expert systems, artificial intelligence systems, robotic process automation systems, machine learning systems, deep learning systems, supervised learning systems, or other intelligent systems as disclosed throughout this disclosure and the documents incorporated herein by reference. As a result, each application in the financial and transactional management application platform layer 502 and each adaptive intelligent system in the adaptive intelligent systems layer 504 can benefit from the data collected or produced by or for each of the others. A wide range of data types may be stored in the storage layer 510 using various storage media and data storage types and formats, including, without limitation: asset and facility data 520 (such as asset identity data, operational data, transactional data, event data, state data, workflow data, maintenance data, pricing data, ownership data, transferability data, and many other types of data relating to an asset (which may be a physical asset, digital asset, virtual asset, financial asset, securities asset, or other asset); worker data 522 (including identity data, role data, task data, workflow data, health data, attention data, mood data, stress data, physiological data, performance data, quality data and many other types); event data 524 (including process events, transaction events, exchange events, pricing events, promotion events, discount events, rebate events, reward events, point utilization events, financial events, output events, input events, state-change events, operating events, repair events, maintenance events, service events, damage events, injury events, replacement events, refueling events, recharging events, supply events, and many others); claims data 554 (such as relating to insurance claims, such as for business interruption insurance, product liability insurance, insurance on goods, facilities, or equipment, flood insurance, insurance for contract-related risks, and many others, as well as claims data relating to product liability, general liability, workers compensation, injury and other liability claims and claims data relating to contracts, such as supply contract performance claims, product delivery requirements, contract claims, claims for damages, claims to redeem points or rewards, claims of access rights, warranty claims, indemnification claims, energy production requirements, delivery requirements, timing requirements, milestones, key performance indicators and others); accounting data 558 (such as data relating to debits, credits, costs, prices, profits, margins, rates of return, valuation, write-offs, and many others); underwriting data 560 (such as data relating to identities of prospective and actual parties involved insurance and other transactions, actuarial data, data relating to probability of occurrence and/or extent of risk associated with activities, data relating to observed activities and other data used to underwrite or estimate risk); access data 562 (such as data relating to rights of access, tickets, tokens, licenses and other access rights described throughout this disclosure, including data structures representing access rights; pricing data 564 (including spot market pricing, forward market pricing, pricing discount information, promotional pricing, and other information relating to the cost or price of items in any of the platform-operated marketplaces 527 and/or external marketplaces 590); as well as other types of data not shown, such as production data (such as data relating to production of physical or digital goods, services, events, content, and the like, as well as data relating to energy production found in databases of public utilities or independent services organizations that maintain energy infrastructure, data relating to outputs of banking, data related to outputs of mining and energy extraction facilities, outputs of drilling and pipeline facilities and many others); and supply chain data (such as relating to items supplied, amounts, pricing, delivery, sources, routes, customs information and many others).

In embodiments, the data handling layers 508 are configured in a topology that facilitates shared adaptation capabilities, which may be provided, managed, mediated and the like by one or more of a set of services, components, programs, systems, or capabilities of the adaptive intelligent systems layer 504, referred to in some cases herein for convenience as the adaptive intelligent systems layer 504. The adaptive intelligent systems layer 504 may include a set of data processing, artificial intelligence, and computational systems 514 that are described in more detail elsewhere throughout this disclosure. Thus, use of various resources, such as computing resources (such as available processing cores, available servers, available edge computing resources, available on-device resources (for single devices or peered networks), and available cloud infrastructure, among others), data storage resources (including local storage on devices, storage resources in or on financial entities or environments (including on-device storage, storage on asset tags, local area network storage and the like), network storage resources, cloud-based storage resources, database resources and others), networking resources (including cellular network spectrum, wireless network resources, fixed network resources and others), energy resources (such as available battery power, available renewable energy, fuel, grid-based power, and many others) and others may be optimized in a coordinated or shared way on behalf of an operator, enterprise, or the like, such as for the benefit of multiple applications, programs, workflows, or the like. For example, the adaptive intelligent system layer 504 may manage and provision available network resources for both a financial analytics application and for a financial remote control application (among many other possibilities), such that low latency resources are used for remote control and longer latency resources are used for the analytics application. As described in more detail throughout this disclosure and the documents incorporated herein by reference, a wide variety of adaptations may be provided on behalf of the various services and capabilities across the various layers 508, including ones based on application requirements, quality of service, budgets, costs, pricing, risk factors, operational objectives, efficiency objectives, optimization parameters, returns on investment, profitability, uptime/downtime, worker utilization, and many others.

The financial and transactional management application platform layer 502, referred to in some cases herein for convenience as the financial and transactional management application platform layer 502, may include a set of financial and transactional processes, workflows, activities, events and applications 512 (referred to collectively, except where context indicates otherwise, as applications 512) that enable an operator to manage more than one aspect of an financial or transactional environment or entity 530 in a common application environment, such as one that takes advantage of common data storage in the data storage layer 510, common data collection or monitoring in the financial and transactional monitoring systems layer 506 and/or common adaptive intelligence of the adaptive intelligent system layer 504. Outputs from the applications 512 in the financial and transactional management application platform layer 502 may be provided to the other data handing layers 508. These may include, without limitation, state and status information for various objects, entities, processes, flows and the like; object information, such as identity, attribute and parameter information for various classes of objects of various data types; event and change information, such as for workflows, dynamic systems, processes, procedures, protocols, algorithms, and other flows, including timing information; outcome information, such as indications of success and failure, indications of process or milestone completion, indications of correct or incorrect predictions, indications of correct or incorrect labeling or classification, and success metrics (including relating to yield, engagement, return on investment, profitability, efficiency, timeliness, quality of service, quality of product, customer satisfaction, and others) among others. Outputs from each application 512 can be stored in the data storage layer 510, distributed for processing by the data collection layer 518, and used by the adaptive intelligent system layer 504. The cross-application nature of the financial and transactional management application platform layer 502 thus facilitates convenient organization of all of the necessary infrastructure elements for adding intelligence to any given application, such as by supplying machine learning on outcomes across applications, providing enrichment of automation of a given application via machine learning based on outcomes from other applications (or other elements of the platform 500, and allowing application developers to focus on application-native processes while benefiting from other capabilities of the platform 500.

Referring to FIG. 6, additional details, components, sub-systems, and other elements of an optional embodiment of the transactional, financial and marketplace enablement system 500 of FIG. 5 are illustrated. The financial and transactional management application platform layer 502 may, in various optional embodiments, include a set of applications, systems, solutions, interfaces, or the like, collectively referred to for convenience as applications 512, by which an operator or owner of a transactional or financial entity, or other users, may manage, monitor, control, analyze, or otherwise interact with one or more elements of the entity 530, such as any of the elements noted in connection above in connection FIG. 5. The set of applications 512 may include, without limitation, one or more of any of a wide range of types of applications, such as an investment application 602 (such as, without limitation, for investment in shares, interests, currencies, commodities, options, futures, derivatives, real property, trusts, cryptocurrencies, tokens, and other asset classes); an asset management application 604 (such as, without limitation, for managing investment assets, real property, fixtures, personal property, real estate, equipment, intellectual property, vehicles, human resources, software, information technology resources, data processing resources, data storage resources, power generation and/or storage resources, computational resources and other assets); a lending application 610 (such as, without limitation, for personal lending, commercial lending, collateralized lending, microlending, peer-to-peer lending, insurance-related lending, asset-backed lending, secured debt lending, corporate debt lending, student loans, mortgage lending, automotive lending, and others); a risk management application 608 (such as, without limitation, for managing risk or liability with respect to a product, an asset, a person, a home, a vehicle, an item of equipment, a component, an information technology system, a security system, a security event, a cybersecurity system, an item of property, a health condition, mortality, fire, flood, weather, disability, malpractice, business interruption, infringement, advertising injury, slander, libel, violation of privacy or publicity rights, injury, damage to property, damage to a business, breach of a contract, and others); a payments application 633 (such as for enabling various payments within and across marketplaces, including credit card, debit card, wire transfer, ACH, checking, currency and other payments); a marketing application 612 (such as, without limitation, an application for marketing a financial or transactional product or service, an advertising application, a marketplace platform or system for goods, services or other items, a marketing analytics application, a customer relationship management application, a search engine optimization application, a sales management application, an advertising network application, a behavioral tracking application, a marketing analytics application, a location-based product or service targeting application, a collaborative filtering application, a recommendation engine for a product or service, and others); a trading application 628 (such as, without limitation, a buying application, a selling application, a bidding application, an auction application, a reverse auction application, a bid/ask matching application, a securities trading application, a commodities trading application, an option trading application, a futures trading application, a derivatives trading application, a cryptocurrency trading application, a token-trading application, an analytic application for analyzing financial or transactional performance, yield, return on investment, or other metrics, a book-building application, or others); a tax application 614 (such as, without limitation, for managing, calculating, reporting, optimizing, or otherwise handling data, events, workflows, or other factors relating to a tax, a levy, a tariff, a duty, a credit, a fee or other government-imposed charge, such as, without limitation, sales tax, income tax, property tax, municipal fees, pollution tax, renewal energy credit, pollution abatement credit, value added tax, import duties, export duties, and others); a fraud prevention application 616 (such as, without limitation, one or more of an identity verification application, a biometric identify validation application, a transactional pattern-based fraud detection application, a location-based fraud detection application, a user behavior-based fraud detection application, a network address-based fraud detection application, a black list application, a white list application, a content inspection-based fraud detection application, or other fraud detection application, a financial service, application or solution 609 (referred to collectively as a “financial service”, such as, without limitation, a financial planning service, a tax planning service, a portfolio management service, a transaction service, a lending service, a banking service, a currency conversion service, a currency exchange service, a remittance service, a money transfer service, a wealth management service, an estate planning service, an investment banking service, a commercial banking service, a foreign exchange service, an insurance service, an investment service, an investment management service, a hedge fund service, a mutual fund service, a custody service, a credit card service, a safekeeping service, a checking service, a debit card service, a lending service, an ATM service, an ETF service, a wire transfer service, an overdraft service, a reporting service, a certified checking service, a notary service, a capital markets service, a brokerage service, a broker-dealer service, a private banking service, an insurance service, an insurance brokerage service, an underwriting service, an annuity service, a life insurance service, a health insurance service, a retirement insurance service, a property insurance service, a casualty insurance service, a finance and insurance service, a reinsurance service, an intermediation service, a trade clearinghouse service, a private equity service, a venture capital service, an angel investment service, a family office investment service, an exchange service, a payments service, a settlement service, an interbank networking service, a debt resolution service, or other financial service); a security application, solution or service 618 (referred to herein as a security application, such as, without limitation, any of the fraud prevention applications 616 noted above, as well as a physical security system (such as for an access control system (such as using biometric access controls, fingerprinting, retinal scanning, passwords, and other access controls), a safe, a vault, a cage, a safe room, or the like), a monitoring system (such as using cameras, motion sensors, infrared sensors and other sensors), a cyber security system (such as for virus detection and remediation, intrusion detection and remediation, spam detection and remediation, phishing detection and remediation, social engineering detection and remediation, cyber-attack detection and remediation, packet inspection, traffic inspection, DNS attack remediation and detection, and others) or other security application); an underwriting application 620 (such as, without limitation, for underwriting any insurance offering, any loan, or any other transaction, including any application for detecting, characterizing or predicting the likelihood and/or scope of a risk, including underwriting based on any of the data sources, events or entities noted throughout this disclosure or the documents incorporated herein by reference); a blockchain application 622 (such as, without limitation, a distributed ledger capturing a series of transactions, such as debits or credits, purchases or sales, exchanges of in kind consideration, smart contract events, or the like, a cryptocurrency application, or other blockchain-based application); a real estate application 624 (such as, without limitation, a real estate brokerage application, a real estate valuation application, a real estate investment trust application, a real estate mortgage or lending application, a real estate assessment application, a real estate marketing application, or other); a regulatory application 626 (such as, without limitation, an application for regulating any of the applications, services, transactions, activities, workflows, events, entities, or other items noted herein and in the documents incorporated by reference herein, such as regulation of pricing, marketing, offering of securities, offering of insurance, undertaking of broker or dealer activities, use of data (including data privacy regulations, regulations relating to storage of data and others), banking, marketing, sales, financial planning, and many others); a platform-operated marketplace 527 application, solution or service (referred to in some cases simply as a marketplace application (which term may also, as context permits include various types of external marketplaces 590), such as, without limitation an e-commerce marketplace, an auction marketplace, a physical goods marketplace, a virtual goods marketplace, an advertising marketplace, a reverse-auction marketplace, an advertising network, a marketplace for attention resources, an energy trading marketplace, a marketplace for computing resources, a marketplace for networking resources, a spectrum allocation marketplace, an Internet advertising marketplace, a television advertising marketplace, a print advertising marketplace, a radio advertising marketplace, an in-game advertising marketplace, an in-virtual reality advertising marketplace, an in-augmented reality marketplace, a real estate marketplace, a hospitality marketplace, a travel services marketplace, a financial services marketplace, a blockchain-based marketplace, a cryptocurrency marketplace, a token-based marketplace, a loyalty program marketplace, a time share marketplace, a rideshare marketplace, a mobility marketplace, a transportation marketplace, a space-sharing marketplace, or other marketplace); a warranty application 617 (such as, without limitation, an application for a warranty or guarantee with respect to a product, a service, an offering, a solution, a physical product, software, a level of service, quality of service, a financial instrument, a debt, an item of collateral, performance of a service, or other item); an analytics solution 619 (such as, without limitation, an analytic application with respect to any of the data types, applications, events, workflows, or entities mentioned throughout this disclosure or the documents incorporated by reference herein, such as a big data application, a user behavior application, a prediction application, a classification application, a dashboard, a pattern recognition application, an econometric application, a financial yield application, a return on investment application, a scenario planning application, a decision support application, and many others); a pricing application 621 (such as, without limitation, for pricing of goods, services (including any mentioned throughout this disclosure and the documents incorporated by reference herein), applications (including any mentioned throughout this disclosure and the documents incorporated by reference herein), software, data services, insurance, virtual goods, advertising placements, search engine and keyword placements, and many others; and a smart contract application, solution, or service (referred to collectively herein as a smart contract application, such as, without limitation, any of the smart contract types referred to in this disclosure or in the documents incorporated herein by reference, such as a smart contract using a token or cryptocurrency for consideration, a smart contract that vests a right, an option, a future, or an interest based on a future condition, a smart contract for a security, commodity, future, option, derivative, or the like, a smart contract for current or future resources, a smart contract that is configured to account for or accommodate a tax, regulatory or compliance parameter, a smart contract that is configured to execute an arbitrage transaction, or many others). Thus, the financial and transactional management application platform layer 502 may host an enable interaction among a wide range of disparate applications 512 (such term including the above-referenced and other financial or transactional applications, services, solutions, and the like), such that by virtue of shared microservices, shared data infrastructure, and shared intelligence, any pair or larger combination or permutation of such services may be improved relative to an isolated application of the same type.

In embodiments, the adaptive intelligent systems layer 504 may include a set of systems, components, services, and other capabilities that collectively facilitate the coordinated development and deployment of intelligent systems, such as ones that can enhance one or more of the applications 512 at the financial and transactional management application platform layer 502. These adaptive intelligence systems layer 504 may include an adaptive edge compute management solution 630, a robotic process automation system 642, a set of protocol adaptors 691, a packet acceleration system 634, an edge intelligence system 638, an adaptive networking system 640, a set of state and event managers 644, a set of opportunity miners 646, a set of artificial intelligence systems 648 and other systems.

In embodiments, the financial and transactional monitoring systems layer 506 and its data collection systems 518 may include a wide range of systems for collection of data. This layer may include, without limitation, real time monitoring systems 668 (such as onboard monitoring systems like event and status reporting systems on ATMs, POS systems, kiosks, vending machines and the like; OBD and telematics systems on vehicle and equipment; systems providing diagnostic codes and events via an event bus, communication port, or other communication system; monitoring infrastructure (such as cameras, motion sensors, beacons, RFID systems, smart lighting systems, asset tracking systems, person tracking systems, and ambient sensing systems located in various environments where transactions and other events take place), as well as removable and replaceable monitoring systems, such as portable and mobile data collectors, RFID and other tag readers, smart phones, tablets and other mobile device that are capable of data collection and the like); software interaction observation systems 650 (such as for logging and tracking events involved in interactions of users with software user interfaces, such as mouse movements, touchpad interactions, mouse clicks, cursor movements, keyboard interactions, navigation actions, eye movements, finger movements, gestures, menu selections, and many others, as well as software interactions that occur as a result of other programs, such as over APIs, among many others); mobile data collectors 652 (such as described extensively herein and in documents incorporated by reference), visual monitoring systems 654 (such as using video and still imaging systems, LIDAR, IR and other systems that allow visualization of items, people, materials, components, machines, equipment, personnel, gestures, expressions, positions, locations, configurations, and other factors or parameters of entities 530, as well as inspection systems that monitor processes, activities of workers and the like); point of interaction systems 670 (such as point of sale systems, kiosks, ATMs, vending machines, touch pads, camera-based interaction tracking systems, smart shopping carts, user interfaces of online and in-store vending and commerce systems, tablets, and other systems at the point of sale or other interaction by a customer or worker involved in shopping and/or a transaction); physical process interaction observation systems 658 (such as for tracking physical activities of customers, physical activities of transaction parties (such as traders, vendors, merchants, customers, negotiators, brokers, and the like), physical interactions of workers with other workers, interactions of workers with physical entities like machines and equipment, and interactions of physical entities with other physical entities, including, without limitation, by use of video and still image cameras, motion sensing systems (such as including optical sensors, LIDAR, IR and other sensor sets), robotic motion tracking systems (such as tracking movements of systems attached to a human or a physical entity) and many others; machine state monitoring systems 660 (including onboard monitors and external monitors of conditions, states, operating parameters, or other measures of the condition of a machine, such as a client, a server, a cloud resource, an ATM, a kiosk, a vending machine, a POS system, a sensor, a camera, a smart shopping cart, a smart shelf, a vehicle, a robot, or other machine); sensors and cameras 662 and other IoT data collection systems 664 (including onboard sensors, sensors or other data collectors (including click tracking sensors) in or about a financial or transactional environment (such as, without limitation, an office, a back office, a store, a mall, a virtual store, an online environment, a website, a bank, or many others), cameras for monitoring an entire environment, dedicated cameras for a particular machine, process, worker, or the like, wearable cameras, portable cameras, cameras disposed on mobile robots, cameras of portable devices like smart phones and tablets, and many others, including any of the many sensor types disclosed throughout this disclosure or in the documents incorporated herein by reference); indoor location monitoring systems 672 (including cameras, IR systems, motion-detection systems, beacons, RFID readers, smart lighting systems, triangulation systems, RF and other spectrum detection systems, time-of-flight systems, chemical noses and other chemical sensor sets, as well as other sensors); user feedback systems 674 (including survey systems, touch pads, voice-based feedback systems, rating system, expression monitoring systems, affect monitoring systems, gesture monitoring systems, and others); behavioral monitoring systems 678 (such as for monitoring movements, shopping behavior, buying behavior, clicking behavior, behavior indicating fraud or deception, user interface interactions, product return behavior, behavior indicative of interest, attention, boredom or the like, mood-indicating behavior (such as fidgeting, staying still, moving closer, or changing posture) and many others); and any of a wide variety of Internet of Things (IoT) data collectors 664, such as those described throughout this disclosure and in the documents incorporated by reference herein.

In embodiments, the financial entity-oriented data storage systems layer 510 may include a range of systems for storage of data, such as the accounting data 558, access data 562, pricing data 564, asset and facility data 520, worker data 522, event data 524, underwriting data 560 and claims data 554. These may include, without limitation, physical storage systems, virtual storage systems, local storage systems, distributed storage systems, databases, memory, network-based storage, network-attached storage systems (such as using NVME, storage attached networks, and other network storage systems), and many others. In embodiments, the storage layer 510 may store data in one or more knowledge graphs (such as a directed acyclic graph, a data map, a data hierarchy, a data cluster including links and nodes, a self-organizing map, or the like). In embodiments, the data storage layer 510 may store data in a digital thread, ledger, or the like, such as for maintaining a longitudinal record of an entity 530 over time, including any of the entities described herein. In embodiments, the data storage layer 510 may use and enable a virtual asset tag 688, which may include a data structure that is associated with an asset and accessible and managed as if the tag were physically located on the asset, such as by use of access controls, so that storage and retrieval of data is optionally linked to local processes, but also optionally open to remote retrieval and storage options. In embodiments, the storage layer 510 may include one or more blockchains 690, such as ones that store identity data, transaction data, entity data for the entities 530, pricing data, ownership transfer data, data for operation by smart contracts 631, historical interaction data, and the like, such as with access control that may be role-based or may be based on credentials associated with an entity 530, a service, or one or more applications 512.

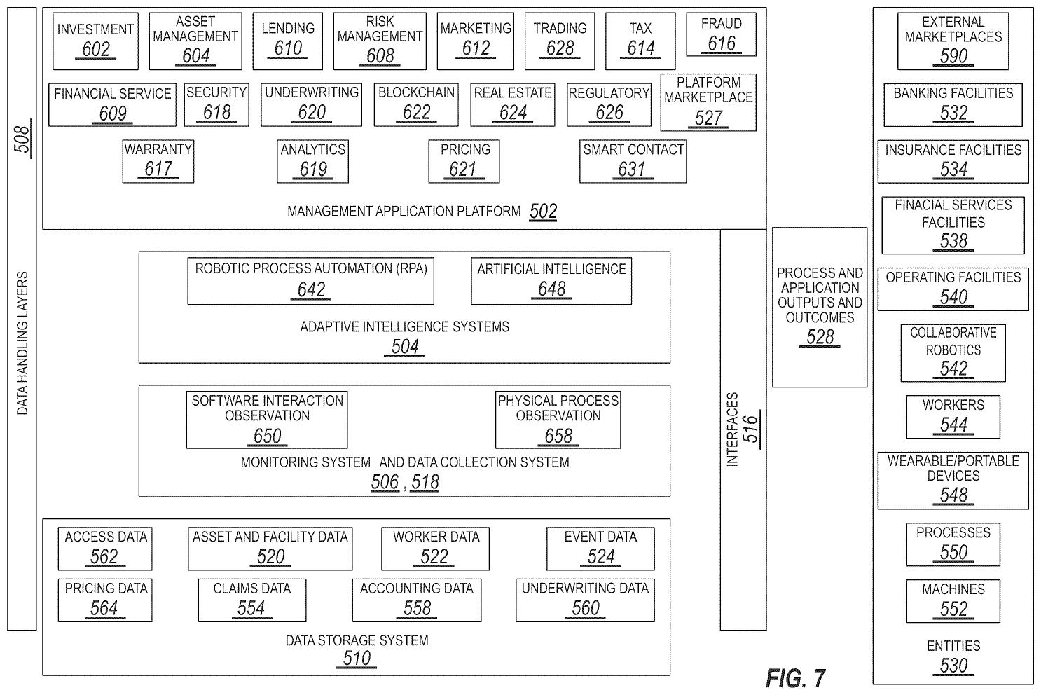

Referring to FIG. 7, the adaptive intelligent systems layer 504 may include a robotic process automation (RPA) system 642, which may include a set of components, processes, services, interfaces and other elements for development and deployment of automation capabilities for various financial entities 530, environments, and applications 512. Without limitation, robotic process automation 642 may be applied to each of the processes that is managed, controlled, or mediated by each of the set of applications 512 of the platform application layer.

In embodiments, robotic process automation 642 may take advantage of the presence of multiple applications 512 within the financial and transactional management application platform layer 502, such that a pair of applications may share data sources (such as in the data storage layer 510) and other inputs (such as from the monitoring layer 506) that are collected with respect to financial entities 530, as well sharing outputs, events, state information and outputs, which collectively may provide a much richer environment for process automation, including through use of artificial intelligence 648 (including any of the various expert systems, artificial intelligence systems, neural networks, supervised learning systems, machine learning systems, deep learning systems, and other systems described throughout this disclosure and in the documents incorporated by reference). For example, a real estate application 624 may use robotic process automation 642 for automation of a real estate inspection process that is normally performed or supervised by a human (such as by automating a process involving visual inspection using video or still images from a camera or other that displays images of an entity 530, such as where the robotic process automation 642 system is trained to automate the inspection by observing interactions of a set of human inspectors or supervisors with an interface that is used to identify, diagnose, measure, parameterize, or otherwise characterize possible defects or favorable characteristics of a house, a building, or other real estate property or item. In embodiments, interactions of the human inspectors or supervisors may include a labeled data set where labels or tags indicate types of defects, favorable properties, or other characteristics, such that a machine learning system can learn, using the training data set, to identify the same characteristics, which in turn can be used to automate the inspection process such that defects or favorable properties are automatically classified and detected in a set of video or still images, which in turn can be used within the real estate solution 624 to flag items that require further inspection, that should be rejected, that should be disclosed to a prospective buyer, that should be remediated, or the like. In embodiments, robotic process automation 642 may involve multi-application or cross-application sharing of inputs, data structures, data sources, events, states, outputs, or outcomes. For example, the real estate application 624 may receive information from a platform-operated marketplace application 527 that may enrich the robotic process automation 642 of the real estate application 624, such as information about the current pricing of an item from a particular vendor that is located at a real estate property (such as a pool, spa, kitchen appliance, TV or other items), which may assist in populating the characteristics about the real estate for purpose of facilitating an inspection process, a valuation process, a disclosure process, or the like. These and many other examples of multi-application or cross-application sharing for robotic process automation 642 across the applications 512 are encompassed by the present disclosure.

In embodiments, robotic process automation may be applied to shared or converged processes among the various pairs of the applications 512 of the financial and transactional management application platform layer 502, such as, without limitation, of a converged process involving a security application 618 and a lending application 610, integrated automation of blockchain-based applications 622 with platform-operated marketplace applications 527, and many others. In embodiments, converged processes may include shared data structures for multiple applications 512 (including ones that track the same transactions on a blockchain but may consume different subsets of available attributes of the data objects maintained in the blockchain or ones that use a set of nodes and links in a common knowledge graph). For example, a transaction indicating a change of ownership of an entity 530 may be stored in a blockchain and used by multiple applications 512, such as to enable role-based access control, role-based permissions for remote control, identity-based event reporting, and the like. In embodiments, converged processes may include shared process flows across applications 512, including subsets of larger flows that are involved in one or more of a set of applications 512. For example, an underwriting or inspection flow about an entity 530 may serve a lending solution 610, an analytics solution 619, an asset management solution 604, and others.

In embodiments, robotic process automation 642 may be provided for the wide range of financial and transactional processes mentioned throughout this disclosure and the documents incorporated herein by reference, including without limitation energy trading, banking, transportation, storage, energy storage, maintenance processes, service processes, repair processes, supply chain processes, inspection processes, purchase and sale processes, underwriting processes, compliance processes, regulatory processes, fraud detection processes, fault detection processes, power utilization optimization processes, and many others. An environment for development of robotic process automation may include a set of interfaces for developers in which a developer may configure an artificial intelligence system 648 to take inputs from selected data sources of the data storage layer 510 and events or other data from the monitoring systems layer 506 and supply them, such as to a neural network, either as inputs for classification or prediction, or as outcomes. The RPA development environment 642 may be configured to take outputs and outcomes 528 from various applications 512, again to facilitate automated learning and improvement of classification, prediction, or the like that is involved in a step of a process that is intended to be automated. In embodiments, the development environment, and the resulting robotic process automation 642 may involve monitoring a combination of both software interaction observation 650 (e.g., by workers interacting with various software interfaces of applications 512 involving entities 530) and physical process interaction observations 658 (e.g., by watching workers interacting with or using machines, equipment, tools, or the like). In embodiments, software interaction observation 650 may include interactions among software components with other software components, such as how one application 512 interacts via APIs with another application 512. In embodiments, observation of physical process interaction observations 658 may include observation (such as by video cameras, motion detectors, or other sensors, as well as detection of positions, movements, or the like of hardware, such as robotic hardware) of how human workers interact with financial entities 530 (such as locations of workers (including routes taken through a location, where workers of a given type are located during a given set of events, processes or the like, how workers manipulate pieces of equipment or other items using various tools and physical interfaces, the timing of worker responses with respect to various events (such as responses to alerts and warnings), procedures by which workers undertake scheduled maintenance, updates, repairs and service processes, procedures by which workers tune or adjust items involved in workflows, and many others). Physical process interaction observations 658 may include tracking positions, angles, forces, velocities, acceleration, pressures, torque, and the like of a worker as the worker operates on hardware, such as with a tool. Such observations may be obtained by any combination of video data, data detected within a machine (such as of positions of elements of the machine detected and reported by position detectors), data collected by a wearable device (such as an exoskeleton that contains position detectors, force detectors, torque detectors and the like that is configured to detect the physical characteristics of interactions of a human worker with a hardware item for purposes of developing a training data set). By collecting both software interaction observations 650 and physical process interaction observations 658 the RPA system 642 can more comprehensively automate processes involving financial entities 530, such as by using software automation in combination with physical robots.

In embodiments, robotic process automation 642 is configured to train a set of physical robots that have hardware elements that facilitate undertaking tasks that are conventionally performed by humans. These may include robots that walk (including walking up and down stairs), climb (such as climbing ladders), move about a facility, attach to items, grip items (such as using robotic arms, hands, pincers, or the like), lift items, carry items, remove, and replace items, use tools and many others.

With reference to FIG. 7, in embodiments provided herein is a transactional, financial and marketplace enablement system. An example system may include a robotic process automation circuit structured to interpret information from a plurality of data sources, and to interface with a plurality of management applications; wherein the plurality of management applications are each associated with a separate one of a plurality of financial entities; and wherein the robotic process automation circuit further comprises an artificial intelligence circuit structured to improve a process of at least one of the plurality of management applications in response to the information from the plurality of data sources.

Certain further aspects of an example system are described following, any one or more of which may be present in certain embodiments. An example system may include wherein the artificial intelligence circuit further comprises at least one circuit selected from the circuits consisting of: a smart contract services circuit, a valuation circuit, and an automated agent circuit.

An example system may include wherein the plurality of management applications comprise at least two applications selected from the applications consisting of: an investment application, as asset management application, a lending application, a risk management application, a marketing application, a trading application, a tax application, a fraud application, a financial service application, a security application, an underwriting application, a blockchain application, a real estate application, a regulatory application, a platform marketplace application, a warranty application, an analytics application, a pricing application, and a smart contract application.

An example system may include wherein the plurality of data sources comprise at least two applications selected from the applications consisting of: an access data source, an asset and facility data source, a worker data source, a claims data source, an accounting data source, an event data source, and an underwriting data source.

An example system may include wherein the plurality of management applications includes a real estate application, and wherein the robotic process automation circuit is further structured to automate a real estate inspection process.

An example system may include wherein the robotic process automation circuit is further structured to automate the real estate inspection process by performing at least one operation selected from the operations consisting of: providing one of a video inspection command or a camera inspection command; utilizing data from the plurality of data sources to schedule an inspection event; and determining inspection criteria in response to a plurality of inspection data and inspection outcomes, and providing an inspection command in response to the plurality of inspection data and inspection outcomes.

An example system may include wherein the robotic process automation circuit is further structured to automate the real estate inspection process in response to at least one of the plurality of data sources that is not accessible to the real estate application.

An example system may include wherein at least one of the plurality of data sources is not accessible to each of the at least one of the plurality of management applications having an improved process by the robotic automation circuit.

An example system may include wherein the at least one of the plurality of management applications having an improved process by the robotic automation circuit comprises a real estate application, and wherein the at least one of the plurality of data sources comprises at least one data source selected from the data sources consisting of: a claims data source, a pricing data source, an asset and facility data source, a worker data source, and an event data source.

An example system may include wherein the at least one of the plurality of management applications having an improved process by the robotic automation circuit comprises an asset management application, and wherein the at least one of the plurality of data sources comprises at least one data source selected from the data sources consisting of: an access data source, a pricing data source, an accounting data source, a worker data source, and an event data source.

An example system may include wherein the at least one of the plurality of management applications having an improved process by the robotic automation circuit comprises a lending management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic automation circuit comprises a marketing management application, and wherein the at least one of the plurality of data sources comprises at least one data source selected from the data sources consisting of: an asset and facility data source, a claims data source, a worker data source, an event data source, and an underwriting data source.

An example system may include wherein the at least one of the plurality of management applications having an improved process by the robotic automation circuit comprises a trading management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic automation circuit comprises an analytics management application, and wherein the at least one of the plurality of data sources comprises at least one data source selected from the data sources consisting of: an access data source, a claims data source, a worker data source, and an event data source.

An example system may include wherein the robotic process automation circuit is further structured to improve the process at least one of the plurality of management applications by providing an output to at least one entity selected from the entities consisting of: an external marketplace, a banking facility, an insurance facility, a financial service facility, an operating facility, a collaborative robotics facility, a worker, a wearable device, an external process, and a machine.

An example system may include wherein the robotic process automation circuit is further structured to interpret an outcome from the at least one entity, and wherein the artificial intelligence circuit is further structured to iteratively improve the process in response to the outcome from the at least one entity.

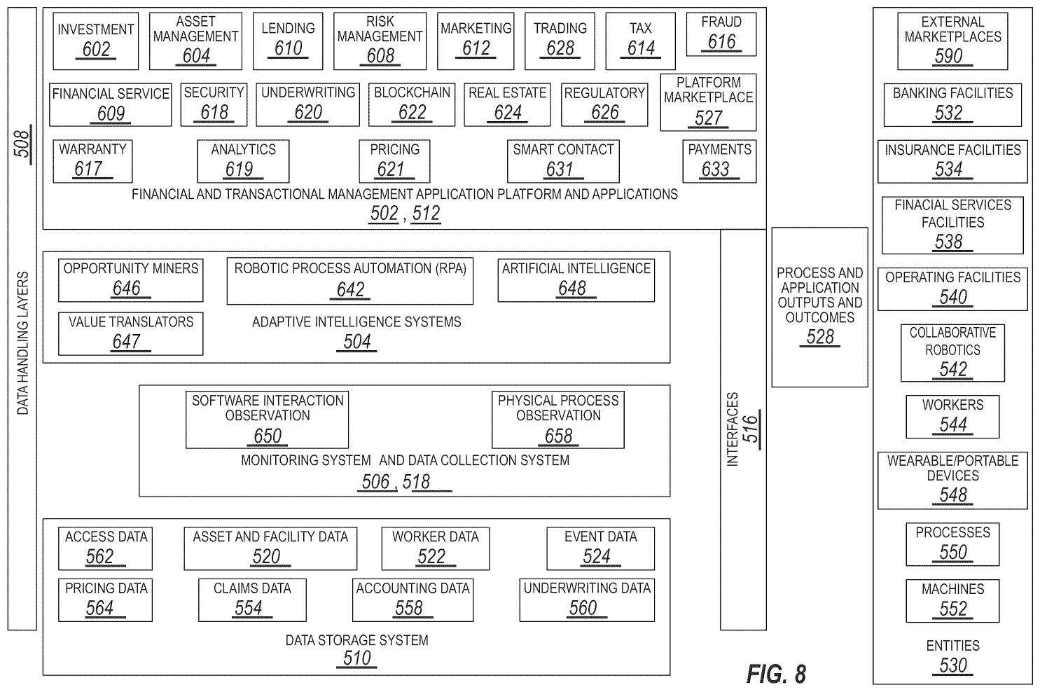

Referring to FIG. 8, a set of opportunity miners 646 may be provided as part of the adaptive intelligent systems layer 504, which may be configured to seek and recommend opportunities to improve one or more of the elements of the platform 500, such as via addition of artificial intelligence 648, automation (including robotic process automation 642), or the like to one or more of the systems, sub-systems, components, applications or the like of the platform 100 or with which the platform 100 interacts. In embodiments, the opportunity miners 646 may be configured or used by developers of AI or RPA solutions to find opportunities for better solutions and to optimize existing solutions. In embodiments, the opportunity miners 646 may include a set of systems that collect information within the platform 100 and collect information within, about and for a set of environments and entities 530, where the collected information has the potential to help identify and prioritize opportunities for increased automation and/or intelligence. For example, the opportunity miners 646 may include systems that observe clusters of workers by time, by type, and by location, such as using cameras, wearables, or other sensors, such as to identify labor-intensive areas and processes in set of financial environments. These may be presented, such as in a ranked or prioritized list, or in a visualization (such as a heat map showing dwell times of customers, workers, or other individuals on a map of an environment or a heat map showing routes traveled by customers or workers within an environment) to show places with high labor activity. In embodiments, analytics solutions 619 may be used to identify which environments or activities would most benefit from automation for purposes of labor saving, profit optimization, yield optimization, increased up time, increased throughput, increased transaction flow, improved security, improved reliability, or other factors.

In embodiments, opportunity miners 646 may include systems to characterize the extent of domain-specific or entity-specific knowledge or expertise required to undertake an action, use a program, use a machine, or the like, such as observing the identity, credentials and experience of workers involved in given processes. This may be of particular benefit in situations where very experienced workers are involved (such as in complex transactions that require significant experience (such as multi-party transactions); in complex back-office processes involving significant expertise or training (such as risk management, actuarial and underwriting processes, asset allocation processes, investment decision processes, or the like); in update, maintenance, porting, backup, or re-build processes on large or complex machines; or in fine-tuning of complex processes where accumulated experience is required for effective work), especially where the population of those workers may be scarce (such as due to retirement or a dwindling supply of new workers having the same credentials). Thus, a set of opportunity miners 646 may collect and supply to an analytics solution 619, such as for prioritizing the development of automation 642, data indicating what processes of or about an entity 530 are most intensively dependent on workers that have particular sets of experience or credentials, such as ones that have experience or credentials that are scarce or diminishing. The opportunity miners 646 may, for example, correlate aggregated data (including trend information) on worker ages, credentials, experience (including by process type) with data on the processes in which those workers are involved (such as by tracking locations of workers by type, by tracking time spent on processes by worker type, and the like). A set of high value automation opportunities may be automatically recommended based on a ranking set, such as one that weights opportunities at least in part based on the relative dependence of a set of processes on workers who are scarce or are expected to become scarcer.

In embodiments, the set of opportunity miners 646 may use information relating to the cost of the workers involved in a set of processes, such as by accessing worker data 522, including human resource database information indicating the salaries of various workers (either as individuals or by type), information about the rates charged by service workers or other contractors, or the like. An opportunity miner 646 may provide such cost information for correlation with process tracking information, such as to enable an analytics solution 619 to identify what processes are occupying the most time of the most expensive workers. This may include visualization of such processes, such as by heat maps that show what locations, routes, or processes are involving the most expensive time of workers in financial environments or with respect to entities 530. The opportunity miners 646 may supply a ranked list, weighted list, or other data set indicating to developers what areas are most likely to benefit from further automation or artificial intelligence deployment.

In embodiments, mining an environment for robotic process automation opportunities may include searching an HR database and/or other labor-tracking database for areas that involve labor-intensive processes; searching a system for areas where credentials of workers indicating potential for automation; tracking clusters of workers by a wearable to find labor-intensive machines or processes; tracking clusters of workers by a wearable by type of worker to find labor-intensive processes, and the like.

In embodiments, opportunity mining may include facilities for solicitation of appropriate training data sets that may be used to facilitate process automation. For example, certain kinds of inputs, if available, would provide very high value for automation, such as video data sets that capture very experienced and/or highly expert workers performing complex tasks. Opportunity miners 646 may search for such video data sets as described herein; however, in the absence of success (or to supplement available data), the platform may include systems by which a user, such as a developer, may specify a desired type of data, such as software interaction data (such as of an expert working with a program to perform a particular task), video data (such as video showing a set of experts performing a certain kind of repair, an expert rebuilding a machine, an expert optimizing a certain kind of complex process, or the like), physical process observation data (such as video, sensor data, or the like). The specification may be used to solicit such data, such as by offering some form of consideration (e.g., monetary reward, tokens, cryptocurrency, licenses or rights, revenue share, or other consideration) to parties that provide data of the requested type. Rewards may be provided to parties for supplying pre-existing data and/or for undertaking steps to capture expert interactions, such as by taking video of a process. The resulting library of interactions captured in response to specification, solicitation and rewards may be captured as a data set in the data storage layer 510, such as for consumption by various applications 512, adaptive intelligent systems layer 504, and other processes and systems. In embodiments, the library may include videos that are specifically developed as instructional videos, such as to facilitate developing an automation map that can follow instructions in the video, such as providing a sequence of steps according to a procedure or protocol, breaking down the procedure or protocol into sub-steps that are candidates for automation, and the like. In embodiments, such videos may be processed by natural language processing, such as to automatically develop a sequence of labeled instructions that can be used by a developer to facilitate a map, a graph, or other model of a process that assists with development of automation for the process. In embodiments, a specified set of training data sets may be configured to operate as inputs to learning. In such cases the training data may be time-synchronized with other data within the platform 500, such as outputs and outcomes from applications 512, outputs and outcomes of financial entities 530, or the like, so that a given video of a process can be associated with those outputs and outcomes, thereby enabling feedback on learning that is sensitive to the outcomes that occurred when a given process that was captured (such as on video, or through observation of software interactions or physical process interactions).

In embodiments, opportunity miners 646 may include methods, systems, processes, components, services, and other elements for mining for opportunities for smart contract definition, formation, configuration, and execution. Data collected within the platform 500, such as any data handled by the data handling layers 508, stored by the data storage layer 510, collected by the monitoring systems layer 506 and data collection systems 518, collected about or from entities 530 or obtained from external sources may be used to recognize beneficial opportunities for application or configuration of smart contracts. For example, pricing information about an entity 530, handled by a pricing application 621, or otherwise collected, may be used to recognize situations in which the same item or items is disparately priced (in a spot market, futures market, or the like), and the opportunity miner 646 may provide an alert indicating an opportunity for smart contract formation, such as a contract to buy in one environment at a price below a given threshold and sell in another environment at a price above a given threshold, or vice versa. In embodiments, robotic process automation 642 may be used to automate smart contract creation, configuration, and/or execution, such as by training on a training set of data relating to experts who form such contract or based on feedback on outcomes from past contracts. Smart contract opportunities may also be recognized based on patterns, such as where predictions are used to indicate opportunities for options, futures, derivatives, forward market contracts, and other forward-looking contracts, such as where a smart contract is created based on a prediction that a future condition will arise that creates an opportunity for a favorable exchange, such as an arbitrage transaction, a hedging transaction, an “in-the-money” option, a tax-favored transaction, or the like. In embodiments, at a first step an opportunity miner 646 seeks a price level for an item, service, good, or the like in a set of current or future markets. At a second step the opportunity miner 646 determines a favorable condition for a smart contract (such as an arbitrage opportunity, tax saving opportunity, favorable option, favorable hedge, or the like). At a next step, the opportunity miner 646 may initiate a smart contract process in which a smart contract is pre-configured with a description of an item, a description of a price or other term or condition, a domain for execution (such as a set of markets in which the contract will be formed) and a time. At a next step, an automation process may form the smart contract and execute it within the applicable domains. At a final step the platform may settle the contract, such as when conditions are met. In embodiments, the opportunity miners 646 may be configured to maintain a set of value translators 647 that may be developed to calculate exchange values of different items between and across disparate domains, such as by translating the value of various resources (e.g., computational, bandwidth, energy, attention, currency, tokens, credits (e.g., tax credits, renewable energy credits, pollution credits), cryptocurrency, goods, licenses (e.g., government-issued licenses, such as for spectrum, for the right to perform services or the like, as well as intellectual property licenses, software licenses and others), services and other items) with respect to other such resources, including accounting for any costs of transacting across domains to convert one resource to the other in a contract or series of contracts, such as ones executed via smart contracts. Value translators 647 may translate between and among current (e.g., spot market) value, value in defined futures markets (such as day-ahead energy prices) and predicted future value outside defined futures markets. In embodiments, opportunity miners 646 may operate across pairs or other combinations of value translators (such as across, two, three, four, five or more domains) to define a series of transaction amounts, configurations, domains, and timing that will result in generation of value by virtue of undertaking transactions that result in favorable translation of value. For example, a cryptocurrency token may be exchanged for a pollution credit, which may be used to permit generation of energy, which may be sold for a price that exceeds the value of the cryptocurrency token by more than the cost of creating the smart contract and undertaking the series of exchanges.

With reference to FIG. 8, in embodiments provided herein is a transactional, financial and marketplace enablement system. An example system may include a robotic process automation circuit structured in interpret information from a plurality of data sources, and to interface with a plurality of management applications; wherein the plurality of management applications are each associated with a separate one of a plurality of financial entities; and wherein the robotic process automation circuit further comprises an opportunity miner component structured to determine a process improvement opportunity for at least one of the plurality of management applications in response to the information from the plurality of data sources; and to provide an output to at least one entity associated with the process improvement opportunity in response to the determined process improvement opportunity.

Certain further aspects of an example system are described following, any one or more of which may be present in certain embodiments. An example system may include wherein the plurality of management applications comprise at least two applications selected from the applications consisting of: an investment application, as asset management application, a lending application, a risk management application, a marketing application, a trading application, a tax application, a fraud application, a financial service application, a security application, an underwriting application, a blockchain application, a real estate application, a regulatory application, a platform marketplace application, a warranty application, an analytics application, a pricing application, and a smart contract application.

An example system may include wherein the plurality of data sources comprise at least two applications selected from the applications consisting of: an access data source, an asset and facility data source, a worker data source, a claims data source, an accounting data source, an event data source, and an underwriting data source.

An example system may include wherein the at least one entity each comprise an entity selected from the entities consisting of: an external marketplace, a banking facility, an insurance facility, a financial service facility, an operating facility, a collaborative robotics facility, a worker, a wearable device, an external process, and a machine.

An example system may include wherein the opportunity miner component is further structured to determine a plurality of process improvement opportunities for one of the plurality of management applications in response to the information from the plurality of data sources, and to provide one of a prioritized list or a visualization of the plurality of process improvement opportunities to the one of the plurality of management applications.

An example system may include wherein the opportunity miner component is further structured to determine the process improvement opportunity in response to at least one parameter selected from the parameters consisting of: a time saving value, a cost saving value, and an improved outcome value.

An example system may include wherein the opportunity miner component is further structured to determine the process improvement opportunity in response to a value translation from a value translation application.

An example system may include wherein the plurality of management applications includes a trading application, and wherein the robotic process automation circuit is further structured to automate a trading service process.

An example system may include wherein the robotic process automation circuit is further structured to automate the trading service process by performing at least one operation selected from the operations consisting of: utilizing data from the plurality of data sources to schedule a trading event; and determining trading criteria in response to a plurality of asset data and trading outcomes, and providing a trading command in response to the plurality of asset data and trading outcomes.

An example system may include wherein the robotic process automation circuit is further structured to automate the trading service process in response to at least one of the plurality of data sources that is not accessible to the trading application.

An example system may include wherein the robotic process automation circuit is further structured to improve the process at least one of the plurality of management applications by providing an output to at least one entity selected from the entities consisting of: an external marketplace, a banking facility, an insurance facility, a financial service facility, an operating facility, a collaborative robotics facility, a worker, a wearable device, an external process, and a machine.

An example system may include wherein the robotic process automation circuit is further structured to interpret an outcome from the at least one entity, and wherein the opportunity miner component is further structured to iteratively improve the process in response to the outcome from the at least one entity.

An example system may include wherein at least one of the plurality of data sources is not accessible to each of the at least one of the plurality of management applications having an improved process by the robotic automation circuit.

An example system may include wherein the at least one of the plurality of management applications having an improved process by the robotic automation circuit comprises a tax application, and wherein the at least one of the plurality of data sources comprises at least one data source selected from the data sources consisting of: a claims data source, a pricing data source, an asset and facility data source, a worker data source, and an event data source.

An example system may include wherein the at least one of the plurality of management applications having an improved process by the robotic automation circuit comprises an asset management application, and wherein the at least one of the plurality of data sources comprises at least one data source selected from the data sources consisting of: an access data source, a pricing data source, an accounting data source, a worker data source, and an event data source.

An example system may include wherein the at least one of the plurality of management applications having an improved process by the robotic automation circuit comprises a lending management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic automation circuit comprises a marketing management application, and wherein the at least one of the plurality of data sources comprises at least one data source selected from the data sources consisting of: an asset and facility data source, a claims data source, a worker data source, an event data source, and an underwriting data source.

An example system may include wherein the at least one of the plurality of management applications having an improved process by the robotic automation circuit comprises an investment management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic automation circuit comprises an underwriting management application, and wherein the at least one of the plurality of data sources comprises at least one data source selected from the data sources consisting of: an access data source, a claims data source, a worker data source, and an event data source.

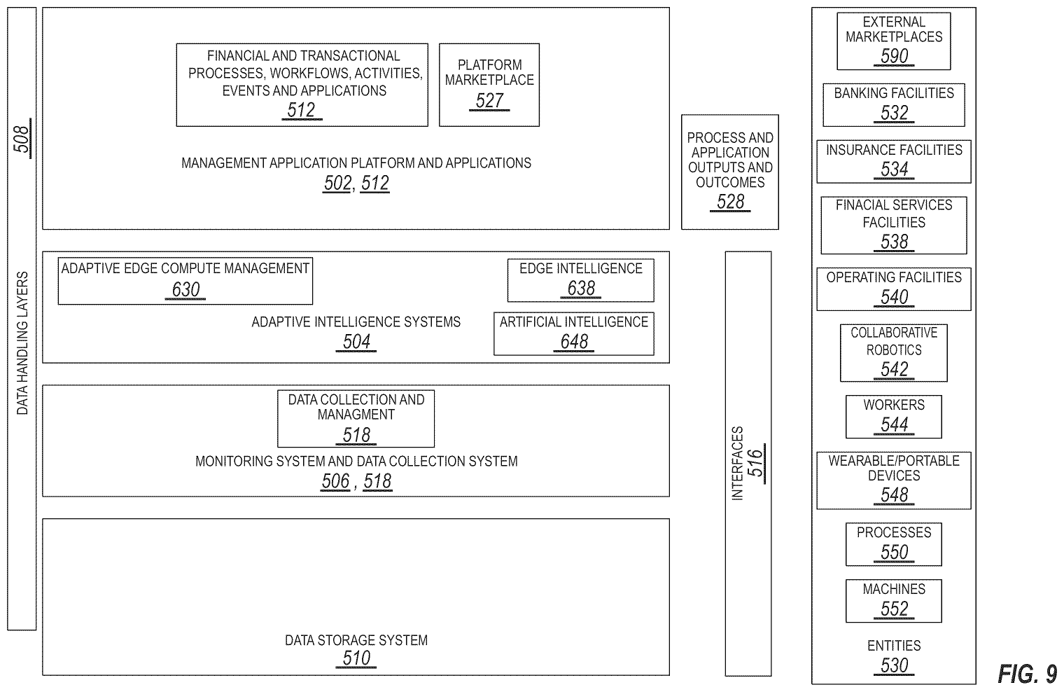

Referring to FIG. 9, additional details of an embodiment of the platform transactional, financial and marketplace enablement system are provided, in particular relating to elements of the adaptive intelligent systems layer 504 that facilitate improved edge intelligence, including the adaptive edge compute management system 630 and the edge intelligence system 638. These elements provide a set of systems that adaptively manage “edge” computation, storage, and processing, such as by varying storage locations for data and processing locations (e.g., optimized by AI) between on-device storage, local systems, in the network and in the cloud. These elements 630, 638 enable facilitation of a dynamic definition by a user, such as a developer, operator, or host of the platform 100, of what constitutes the “edge” for purposes of a given application. For example, for environments where data connections are slow or unreliable (such as where a facility does not have good access to cellular networks (such as due to remoteness of some environments (such as in geographies with poor cellular network infrastructure), shielding or interference (such as where density of network-using systems, thick walls, underground location, or presence of large metal objects (such as vaults) interferes with networking performance), and/or congestion (such as where there are many devices seeking access to limited networking facilities), edge computing capabilities can be defined and deployed to operate on the local area network of an environment, in peer-to-peer networks of devices, or on computing capabilities of local financial entities 530. Where strong data connections are available (such as where good back-haul facilities exist), edge computing capabilities can be disposed in the network, such as for caching frequently used data at locations that improve input/output performance, reduce latency, or the like. Thus, adaptive definition and specification of where edge computing operations is enabled, under control of a developer or operator, or optionally determined automatically, such as by an expert system or automation system, such as based on detected network conditions for an environment, for an entity 530, or for a network as a whole. In embodiments, an edge intelligence system 638 enables adaptation of edge computation (including where computation occurs within various available networking resources, how networking occurs (such as by protocol selection), where data storage occurs, and the like) that is multi-application aware, such as accounting for QoS, latency requirements, congestion, and cost as understood and prioritized based on awareness of the requirements, the prioritization, and the value (including ROI, yield, and cost information, such as costs of failure) of edge computation capabilities across more than one application, including any combinations and subsets of the applications 512 described herein or in the documents incorporated herein by reference.

With reference to FIG. 9, in embodiments provided herein is a transactional, financial and marketplace enablement system. An example system may include an adaptive edge computing circuit structured to interpret information from a plurality of data sources, and to interface with a plurality of management applications; wherein the plurality of management applications are each associated with a separate one of a plurality of financial entities; and wherein the adaptive edge computing circuit further comprises an edge intelligence component structured to determine an edge intelligence process improvement for at least one of the plurality of management applications in response to the information from the plurality of data sources.

Certain further aspects of an example system are described following, any one or more of which may be present in certain embodiments. An example system may include wherein the plurality of management applications comprise at least two applications selected from the applications consisting of: an investment application, as asset management application, a lending application, a risk management application, a marketing application, a trading application, a tax application, a fraud application, a financial service application, a security application, an underwriting application, a blockchain application, a real estate application, a regulatory application, a platform marketplace application, a warranty application, an analytics application, a pricing application, and a smart contract application.

An example system may include wherein the plurality of data sources comprise at least two applications selected from the applications consisting of: an access data source, an asset and facility data source, a worker data source, a claims data source, an accounting data source, an event data source, and an underwriting data source.

An example system may include wherein the at least one entity each comprise an entity selected from the entities consisting of: an external marketplace, a banking facility, an insurance facility, a financial service facility, an operating facility, a collaborative robotics facility, a worker, a wearable device, an external process, and a machine.

An example system may include wherein the edge intelligence component is further structured to determine a plurality of process improvement opportunities for one of the plurality of management applications in response to the information from the plurality of data sources, and to provide one of a prioritized list or a visualization of the plurality of process improvement opportunities to the one of the plurality of management applications.

An example system may include wherein the edge intelligence component is further structured to determine a process improvement opportunity in response to at least one parameter selected from the parameters consisting of: a time saving value, a cost saving value, and an improved outcome value.

An example system may include wherein the plurality of management applications includes a security application, and wherein the adaptive edge computing circuit is further structured to automate a security service process.

An example system may include wherein the adaptive edge computing circuit is further structured to automate the security service process by performing at least one operation selected from the operations consisting of: utilizing data from the plurality of data sources to schedule a security event; and determining security criteria in response to a plurality of asset data and security outcomes, and providing a security command in response to the plurality of asset data and security outcomes.

An example system may include wherein the adaptive edge computing circuit is further structured to automate the security service process in response to at least one of the plurality of data sources that is not accessible to the security application.

An example system may include wherein the adaptive edge computing circuit is further structured to improve the process at least one of the plurality of management applications by providing an output to at least one entity selected from the entities consisting of: an external marketplace, a banking facility, an insurance facility, a financial service facility, an operating facility, a collaborative robotics facility, a worker, a wearable device, an external process, and a machine.

An example system may include wherein the adaptive edge computing circuit is further structured to interpret an outcome from the at least one entity, and wherein the edge intelligence component is further structured to iteratively improve the process in response to the outcome from the at least one entity.

An example system may include wherein at least one of the plurality of data sources is not accessible to each of the at least one of the plurality of management applications having an improved process by the adaptive edge computing circuit.

An example system may include wherein the at least one of the plurality of management applications having an improved process by the adaptive edge computing circuit comprises a risk application, and wherein the at least one of the plurality of data sources comprises at least one data source selected from the data sources consisting of: a claims data source, a pricing data source, an asset and facility data source, a worker data source, and an event data source.

An example system may include wherein the at least one of the plurality of management applications having an improved process by the adaptive edge computing circuit comprises an asset management application, and wherein the at least one of the plurality of data sources comprises at least one data source selected from the data sources consisting of: an access data source, a pricing data source, an accounting data source, a worker data source, and an event data source.

An example system may include wherein the at least one of the plurality of management applications having an improved process by the adaptive edge computing circuit comprises a security management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the adaptive edge computing circuit comprises a platform marketplace application, and wherein the at least one of the plurality of data sources comprises at least one data source selected from the data sources consisting of: an asset and facility data source, a claims data source, a worker data source, an event data source, and an underwriting data source.

An example system may include wherein the at least one of the plurality of management applications having an improved process by the adaptive edge computing circuit comprises a platform marketplace application, and wherein the adaptive edge computing circuit is further structured to operate an interface to interpret an edge definition, and wherein an edge intelligence component is further structured to determine the edge intelligence process improvement in response to the edge definition.

An example system may include wherein the edge definition comprises an identification of at least one of the following parameters: a slow data connection, an unreliable data connection, a network interference description, a network caching description, a quality of service requirement, or a latency requirement.

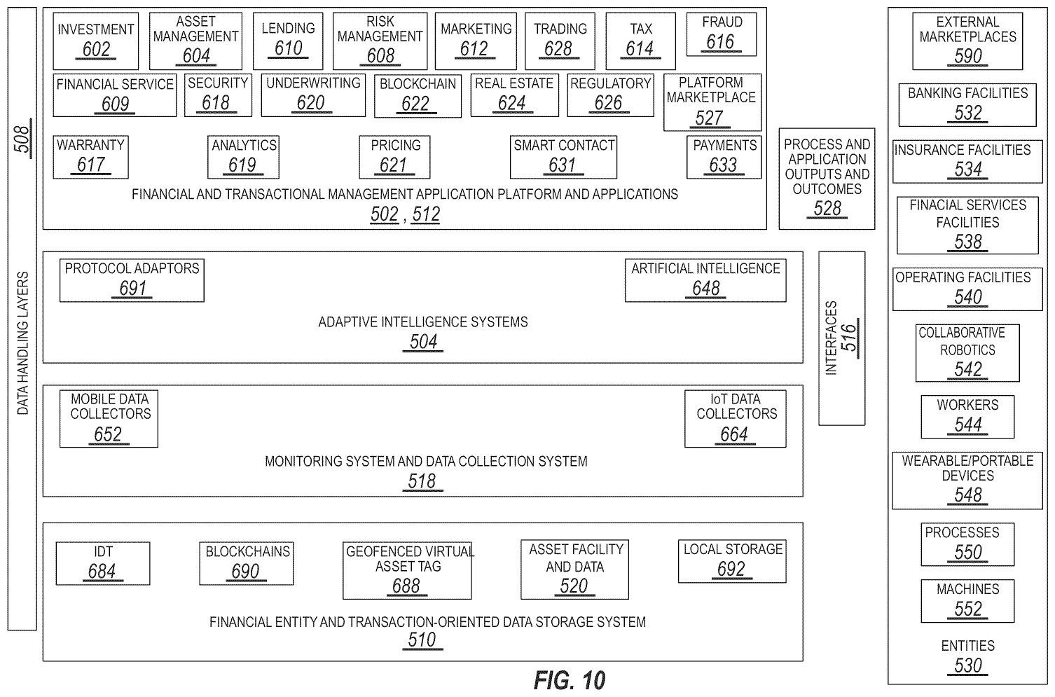

Referring to FIG. 10, additional details, components, sub-systems, and other elements of an optional embodiment of the storage layer 510 of the transactional, financial and marketplace enablement system 500 are illustrated, relating in particular to embodiments that may include a geofenced virtual asset tag 688, such as for one or more assets within the asset and facility data 520 described throughout this disclosure and the document incorporated by reference herein. In embodiments, the virtual asset tag is a data structure that contains data about an entity 530, such as an asset (which may be physical or virtual), machine, item of equipment, item of inventory, manufactured article, certificate (such as a stock certificate), deed, component, tool, device, or worker (among others), where the data is intended to be tagged to the asset, such as where the data relates uniquely to the particular asset (e.g., to a unique identifier for the individual asset) and is linked to proximity or location of the asset (such as being geofenced to an area or location of or near the asset, or being associated with a geo-located digital storage location or defined domain for a digital asset). The virtual asset tag is thus functionally equivalent to a physical asset tag, such as an RFID tag, in that it provides a local reader or similar device to access the data structure (as a reader would access an RFID tag), and in embodiments, access control is managed as if the tag were physical located on an asset; for example, certain data may be encrypted with keys that only permit it to be read, written to, modified, or the like by an operator who is verified to be in the proximity of a tagged financial entity 530, thereby allowing partitioning of local-only data processing from remote data processing. In embodiments, the virtual asset tag may be configured to recognize the presence of an RF reader or other reader (such as by recognition of an interrogation signal) and communicate to the reader, such as with help of protocol adaptors, such as over an RF communication link with the reader, notwithstanding the absence of a conventional RFID tag. This may occur by communications from IoT devices, telematics systems, and by other devices residing on a local area network. In embodiments, a set of IoT devices in a marketplace or financial or transactional environment can act as distributed blockchain nodes, such as for storage of virtual asset tag data, for tracking of transactions, and for validation (such as by various consensus protocols) of enchained data, including transaction history for maintenance, repair and service. In embodiments, the IoT devices in a geofence can collectively validate location and identity of a fixed asset that is tagged by a virtual asset tag, such as where peers or neighbors validate other peers or neighbors as being in a given location, thereby validating the unique identity and location of the asset. Validation can use voting protocols, consensus protocols, or the like. In embodiments, identity of the financial entities that are tagged can be maintained in a blockchain. In embodiments, an asset tag may include information that is related to a digital thread 684, such as historical information about an asset, its components, its history, and the like.

With reference to FIG. 10, in embodiments provided herein is a transactional, financial and marketplace enablement system. An example system may include an adaptive intelligence circuit structured in interpret information from a plurality of data sources, and to interface with a plurality of management applications, wherein the adaptive intelligence circuit comprises a protocol adapter component; wherein the plurality of management applications are each associated with a separate one of a plurality of financial entities; and wherein the adaptive intelligence circuit further comprises an artificial intelligence component structured to determine an artificial intelligence process improvement for at least one of the plurality of management applications in response to the information from the plurality of data sources.

Certain further aspects of an example system are described following, any one or more of which may be present in certain embodiments. An example system may include wherein at least one of the plurality of data sources is a mobile data collector.

An example system may include wherein the adaptive intelligence circuit further comprises a protocol adapter component structured to determine a communication protocol facilitating communication between an entity accessing the at least one of the plurality of management applications having an improved process.

An example system may include wherein the entity accessing the at least one of the plurality of management applications comprises an operator related to the at least one of the plurality of management applications, and wherein the protocol adapter component is further structured to determine the communication protocol as a protocol enabling encrypted communications in response to a determination from the mobile data collector that the operator is in a proximity of a tagged financial entity.

An example system may include wherein the mobile data collector collects data from at least one geofenced virtual asset tag.

An example system may include wherein the adaptive intelligence circuit further comprises a protocol adapter component structured to determine a communication protocol facilitating communication between an entity accessing the at least one of the plurality of management applications having an improved process.

An example system may include wherein the entity accessing the at least one of the plurality of management applications comprises an operator related to the at least one of the plurality of management applications, and wherein the protocol adapter component is further structured to determine the communication protocol as a protocol enabling encrypted communications in response to a determination from the at least one geofenced virtual asset tag that the operator is in a proximity of a tagged financial entity.

An example system may include wherein at least one of the plurality of data sources is an Internet of Things data collector.

An example system may include wherein the adaptive intelligence circuit further comprises a protocol adapter component structured to determine a communication protocol facilitating communication between an entity accessing the at least one of the plurality of management applications having an improved process.

An example system may include wherein the entity accessing the at least one of the plurality of management applications comprises an operator related to the at least one of the plurality of management applications, and wherein the protocol adapter component is further structured to determine the communication protocol as a protocol enabling encrypted communications in response to a determination from the Internet of Things data collector that the operator is in a proximity of a tagged financial entity.

An example system may include wherein at least one of the plurality of data sources is a blockchain circuit, and wherein the adaptive intelligence circuit interprets the information from the blockchain circuit utilizing the adaptive intelligence circuit.

An example system may include wherein the plurality of management applications comprise at least two applications selected from the applications consisting of: an investment application, an asset management application, a lending application, a risk management application, a marketing application, a trading application, a tax application, a fraud application, a financial service application, a security application, an underwriting application, a blockchain application, a real estate application, a regulatory application, a platform marketplace application, a warranty application, an analytics application, a pricing application, and a smart contract application.

An example system may include wherein the plurality of data sources comprise at least two applications selected from the applications consisting of: an access data source, an asset and facility data source, a worker data source, a claims data source, an accounting data source, an event data source, and an underwriting data source.

An example system may include wherein the at least one entity each comprises an entity selected from the entities consisting of: an external marketplace, a banking facility, an insurance facility, a financial service facility, an operating facility, a collaborative robotics facility, a worker, a wearable device, an external process, and a machine.

An example system may include wherein the artificial intelligence component is further structured to determine a plurality of process improvement opportunities for one of the plurality of management applications in response to the information from the plurality of data sources, and to provide one of a prioritized list or a visualization of the plurality of process improvement opportunities to the one of the plurality of management applications.

An example system may include wherein the artificial intelligence component is further structured to determine a process improvement opportunity in response to at least one parameter selected from the parameters consisting of: a time saving value, a cost saving value, and an improved outcome value.

An example system may include wherein the plurality of management applications includes a risk management application, and wherein the adaptive intelligence circuit is further structured to automate a risk management process.

An example system may include wherein the adaptive intelligence circuit is further structured to automate the risk management process by performing at least one operation selected from the operations consisting of: utilizing data from the plurality of data sources to schedule a risk event; determining risk criteria in response to a plurality of asset data and risk outcomes, and providing a risk command in response to the plurality of asset data and risk management outcomes; and adjusting a geofencing location to provide at least one of an improved access for an operator related to at least one of the plurality of management applications or improve a security of communications to at least one of the plurality of management applications.

An example system may include wherein the adaptive intelligence circuit is further structured to automate the risk management process in response to at least one of the plurality of data sources that is not accessible to the risk management application.

An example system may include wherein the adaptive intelligence circuit is further structured to improve the process of at least one of the plurality of management applications by providing an output to at least one entity selected from the entities consisting of: an external marketplace, a banking facility, an insurance facility, a financial service facility, an operating facility, a collaborative robotics facility, a worker, a wearable device, an external process, and a machine.

An example system may include wherein the adaptive intelligence circuit is further structured to interpret an outcome from the at least one entity, and wherein the artificial intelligence component is further structured to iteratively improve the process in response to the outcome from the at least one entity.

An example system may include wherein at least one of the plurality of data sources is not accessible to each of the at least one of the plurality of management applications having an improved process by the adaptive intelligence circuit.

An example system may include wherein the at least one of the plurality of management applications having an improved process by the adaptive intelligence circuit comprises a smart contract application, and wherein the at least one of the plurality of data sources comprises at least one data source selected from the data sources consisting of: a claims data source, a pricing data source, an asset and facility data source, a worker data source, and an event data source.

An example system may include wherein the at least one of the plurality of management applications having an improved process by the adaptive intelligence circuit comprises an asset management application, and wherein the at least one of the plurality of data sources comprises at least one data source selected from the data sources consisting of: an access data source, a pricing data source, an accounting data source, a worker data source, and an event data source.

An example system may include wherein the at least one of the plurality of management applications having an improved process by the adaptive intelligence circuit comprises a security management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the adaptive intelligence circuit comprises a marketing management application, and wherein the at least one of the plurality of data sources comprises at least one data source selected from the data sources consisting of: an asset and facility data source, a claims data source, a worker data source, an event data source, and an underwriting data source.

An example system may include wherein the at least one of the plurality of management applications having an improved process by the adaptive intelligence circuit comprises a pricing management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the adaptive intelligence circuit comprises a warranty management application, and wherein the at least one of the plurality of data sources comprises at least one data source selected from the data sources consisting of: an access data source, a claims data source, a worker data source, and an event data source.

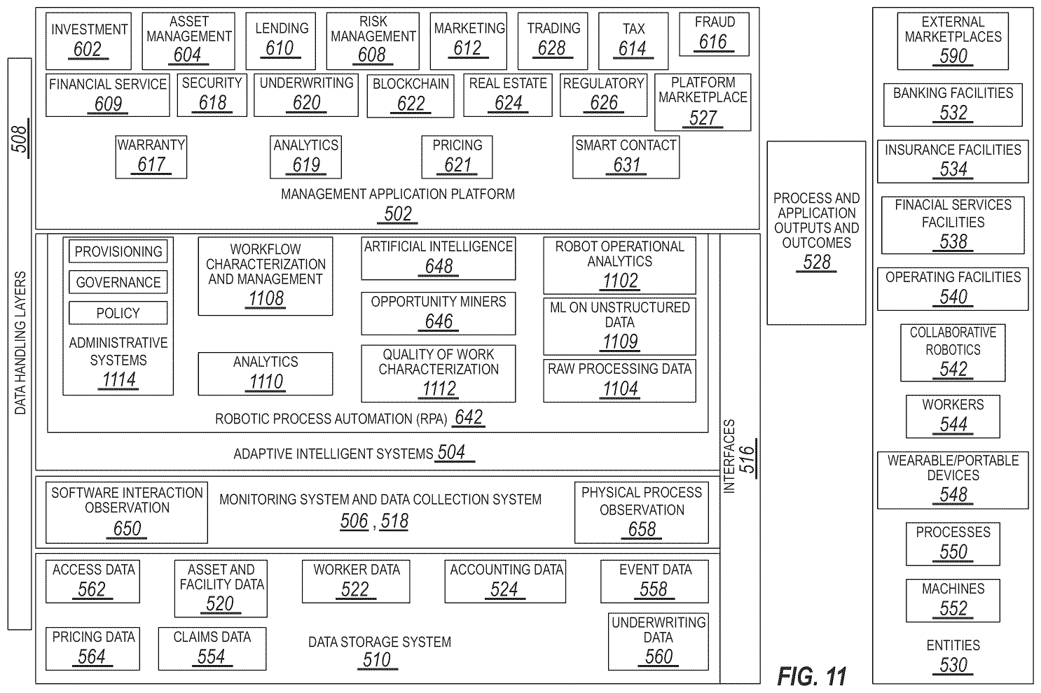

Referring to FIG. 11, in embodiments, a unified RPA system 642, such as for developing and deploying one or more automation capabilities may include or enable capabilities for robot operational analytics 1102, such as for analyzing operational actions of a set of robots, including with respect to location, mobility and routing of mobile robots, as well as with respect to motions of robot components, such as where robotic components are used within a wide range of protocols or procedures, such as banking processes, underwriting processes, insurance processes, risk assessment processes, risk mitigation processes, inspection processes, exchange processes, sale processes, purchase processes, delivery processes, warehousing processes, assembly processes, transport processes, maintenance and repair processes, data collection processes, and many others.

In embodiments, the RPA system 642 may include or enable capabilities for machine learning on unstructured data 1109, such as learning on a training set of human labels, tags, or other activities that allow characterization of the unstructured data, extraction of content from unstructured data, generation of diagnostic codes or similar summaries from content of unstructured data, or the like. For example, the RPA system 642 may include sub-systems or capabilities for processing PDFs (such as technical data sheets, functional specifications, repair instructions, user manuals and other documentation about financial entities 530, such as machines and systems), for processing human-entered notes (such as notes involved in diagnosis of problems, notes involved in prescribing or recommending actions, notes involved in characterizing operational activities, notes involved in maintenance and repair operations, and many others), for processing information unstructured content contained on websites, social media feeds and the like (such as information about products or systems in an financial environment that can be obtained from vendor websites), and many others.

In embodiments, the RPA system 642 may comprise a unified platform with a set of RPA capabilities, as well as systems for monitoring (such as the systems of the monitoring systems layer 506 and data collection systems 518), systems for raw data processing 1104 (such as by optical character recognition (OCR), natural language processing (NPL), computer vision processing, sound processing, sensor processing and the like); systems for workflow characterization and management 1108; analytics capabilities 1110; artificial intelligence capabilities 648; and administrative systems 1114, such as for policy, governance, provisioning (such as of services, roles, access controls, and the like) among others. The RPA system 642 may include such capabilities as a set of microservices in a microservices architecture. The RPA system 642 may have a set of interfaces to other platform layers 508, as well as to external systems, for data exchange, such that the RPA system 642 can be accessed as an RPA platform-as-a-service by external systems that can benefit from one or more automation capabilities.

In embodiments, the RPA system 642 may include a quality-of-work characterization capability 1112, such as one that identifies high quality work as compared to other work. This may include recognizing human work as different from work performed by machines, recognizing which human work is likely to be of highest quality (such as work involving the most experienced or expensive personnel), recognizing which machine-performed work is likely to be of the highest quality (such as work that is performed by machines that have extensively learned on feedback from many outcomes, as compared to machines that are newly deployed, and recognizing which work has historically provided favorable outcomes (such as based on analytics or correlation to past outcomes). A set of thresholds may be applied, which may be varied under control of a developer or other user of the RPA system 642, such as to indicate by type, by quality-level, or the like, which data sets indicating past work will be used for training within machine learning systems that facilitate automation.

With reference to FIG. 11, in embodiments provided herein is a transactional, financial and marketplace enablement system. An example system may include an robotic process automation circuit structured in interpret information from a plurality of data sources, and to interface with a plurality of management applications; wherein the plurality of management applications are each associated with a separate one of a plurality of financial entities; and wherein the robotic process automation circuit further comprises a robot operational analytics component structured to determine a robot operational process improvement for at least one of the plurality of management applications in response to the information from the plurality of data sources.

Certain further aspects of an example system are described following, any one or more of which may be present in certain embodiments. An example system may further include an administrative system circuit structured to adapt the robot operational process improvement through at least one of governance of robotic operations, provisioning robotic operations, or robotic operations policies.

An example system may include wherein the robot operational process improvement comprises a robotic workflow characterization and improvement.

An example system may further include an opportunity mining circuit structured to adapt the operational process improvement to one of the plurality of management applications.

An example system may include wherein the robot operational process improvement comprises a robotic quality of work characterization and improvement.

An example system may include wherein the robot operational analytics component comprises a robotics machine learning component for processing the information from a plurality of data sources to determine the robot operational process improvement.

An example system may include wherein the robot operational analytics component comprises a raw data processing component for processing the information from a plurality of data sources to determine the robot operational process improvement.

An example system may include wherein the plurality of management applications comprise at least two applications selected from the applications consisting of: an investment application, as asset management application, a lending application, a risk management application, a marketing application, a trading application, a tax application, a fraud application, a financial service application, a security application, an underwriting application, a blockchain application, a real estate application, a regulatory application, a platform marketplace application, a warranty application, an analytics application, a pricing application, and a smart contract application.

An example system may include wherein the plurality of data sources comprise at least two applications selected from the applications consisting of: an access data source, an asset and facility data source, a worker data source, a claims data source, an accounting data source, an event data source, and an underwriting data source.

An example system may include wherein the at least one entity each comprise an entity selected from the entities consisting of: an external marketplace, a banking facility, an insurance facility, a financial service facility, an operating facility, a collaborative robotics facility, a worker, a wearable device, an external process, and a machine.

An example system may include wherein the robot operational analytics component is further structured to determine a plurality of process improvement opportunities for one of the plurality of management applications in response to the information from the plurality of data sources, and to provide one of a prioritized list or a visualization of the plurality of process improvement opportunities to the one of the plurality of management applications.

An example system may include wherein the robot operational analytics component is further structured to determine a process improvement opportunity in response to at least one parameter selected from the parameters consisting of: a time saving value, a cost saving value, and an improved outcome value.

An example system may include wherein the plurality of management applications includes a regulatory management application, and wherein the robotic process automation circuit is further structured to automate a regulatory management process.

An example system may include wherein the robotic process automation circuit is further structured to automate the regulatory management process by performing at least one operation selected from the operations consisting of: utilizing data from the plurality of data sources to schedule a regulatory event; and determining regulatory criteria in response to a plurality of asset data and regulatory outcomes, and providing a regulatory command in response to the plurality of asset data and regulatory management outcomes.

An example system may include wherein the robotic process automation circuit is further structured to automate the regulatory management process in response to at least one of the plurality of data sources that is not accessible to the regulatory management application.

An example system may include wherein the robotic process automation circuit is further structured to improve the process at least one of the plurality of management applications by providing an output to at least one entity selected from the entities consisting of: an external marketplace, a banking facility, an insurance facility, a financial service facility, an operating facility, a collaborative robotics facility, a worker, a wearable device, an external process, and a machine.

An example system may include wherein the robotic process automation circuit is further structured to interpret an outcome from the at least one entity, and wherein the robot operational analytics component is further structured to iteratively improve the process in response to the outcome from the at least one entity.

An example system may include wherein at least one of the plurality of data sources is not accessible to each of the at least one of the plurality of management applications having an improved process by the robotic process automation circuit.

An example system may include wherein the at least one of the plurality of management applications having an improved process by the robotic process automation circuit comprises an investment application, and wherein the at least one of the plurality of data sources comprises at least one data source selected from the data sources consisting of: a claims data source, a pricing data source, an asset and facility data source, a worker data source, and an event data source.

An example system may include wherein the at least one of the plurality of management applications having an improved process by the robotic process automation circuit comprises an asset management application, and wherein the at least one of the plurality of data sources comprises at least one data source selected from the data sources consisting of: an access data source, a pricing data source, an accounting data source, a worker data source, and an event data source.

An example system may include wherein the at least one of the plurality of management applications having an improved process by the robotic process automation circuit comprises a security management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic process automation circuit comprises a marketing management application, and wherein the at least one of the plurality of data sources comprises at least one data source selected from the data sources consisting of: an asset and facility data source, a claims data source, a worker data source, an event data source, and an underwriting data source.

An example system may include wherein the at least one of the plurality of management applications having an improved process by the robotic process automation circuit comprises a pricing management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic process automation circuit comprises a warranty management application, and wherein the at least one of the plurality of data sources comprises at least one data source selected from the data sources consisting of: an access data source, a claims data source, a worker data source, and an event data source.

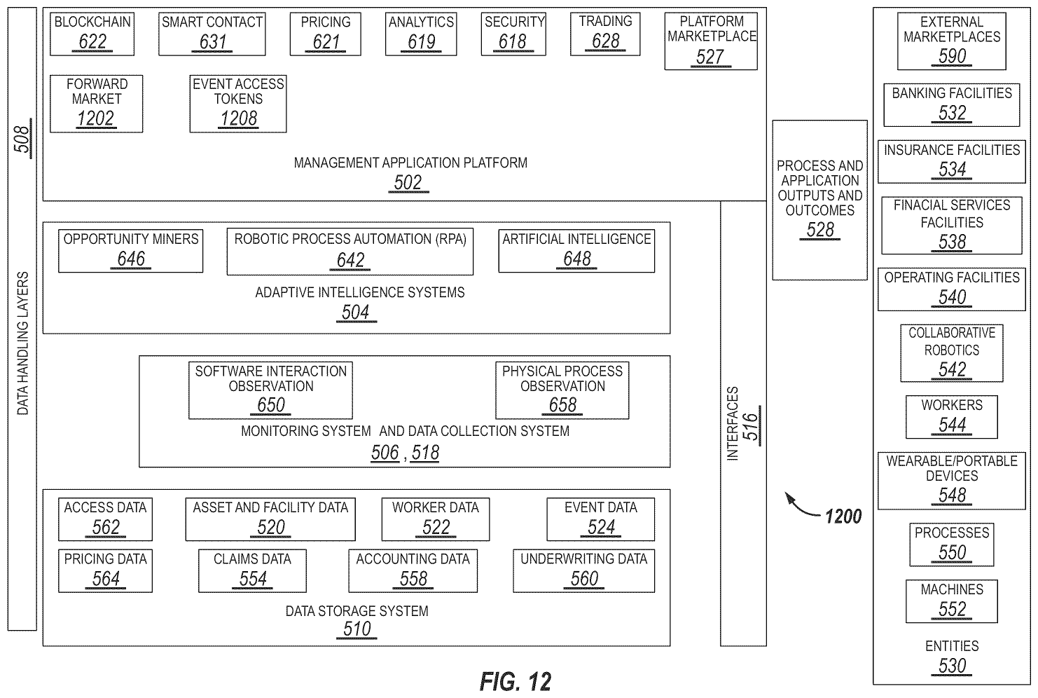

Referring to FIG. 12, in embodiments, various systems, methods, processes, services, components and other elements for enabling a blockchain and smart contract platform for a forward market 1202 for access rights to events. Within a transactional enablement system such as described in connection with various embodiments of the platform 500, a blockchain application 622 and associated smart contract 631 may be used to enable a forward market 1202 for access rights to events, such as where one or more event tickets, seat licenses, access rights, rights of entry, passes (e.g., backstage passes) or other items representing, comprising or embodying an access token for the right to attend, enter, view, consume, or otherwise participate in an event (which may be a live event, a recorded event, an event at a physical venue, a digital content event, or other event to which access is controlled) (all of which are encompassed by the term access token 1208 as used herein, except where context indicates otherwise) is securely stored on a blockchain that is configured by a blockchain application 622, such as one in which the blockchain 622 comprises a ledger of transactions in access tokens 1208 (such term comprising tickets and other evidence of the right to access the event), such as with indications of ownership (including identity information, event information, token information, information about terms and conditions, and the like) and a record of transfer of ownership (including terms, condition and policies regarding transferability). In embodiments, such a blockchain-based access token may be traded in a platform-operated marketplace application 527, such as one configured to operate with or for a spot market or forward market 1202. In embodiments, the forward market 1202 operated within or by the platform may be a contingent forward market, such as one where a future right vests, is triggered, or emerges based on the occurrence of an event, satisfaction of a condition, or the like, such as enabled by a smart contract 631 that operates on one or more data structures in or associated with a platform-operated marketplace 527 or an external marketplace 590 to execute or apply a rule, term, condition or the like, optionally resulting in a transaction that is recorded in the blockchain (such as on a distributed ledger on the blockchain), which may, in turn, initiate other processes and result in other smart contract operations. In such embodiments, a condition triggering an event may include an event promotor or other party scheduling an event having a defined set of parameters, an event arising having such parameters, or the like, and the blockchain-based access token 1208 may be configured (optionally in conjunction with a smart contract 631 and with one or more monitoring systems 506) to recognize the presence or existence, such as in an external marketplace 590 of an event, or an access token to an event, that satisfies the defined set of parameters and to initiate an operation with respect to the access token, such as reporting the existence of availability of the access token, transferring access to the access token, transferring ownership, setting a price, or the like. In embodiments, monitoring system layers 506 may monitor external marketplaces 590 for relevant events, tokens, and the like, as well as for information indicating the emergence of conditions that satisfy one or more conditions that result in triggering, vesting, or emergence of a condition that impacts an access token or event. As an illustrative example, a sporting event access token 1208 to a playoff game may be configured to vest upon the presence of a specific team in a specific game (e.g., the Super Bowl), at which point the right to a ticket to a specific seat may be automatically allocated on a distributed ledger, enabled by a blockchain, to the individual listed on the ledger as having the right to the ticket for that team. Thus, a distributed ledger or other blockchains 622 may securely maintain multiple prospective owners for an event token 1208 for the same event, provided access rights can be divided such that they are mutually exclusive but can be designated to a specific owner upon the emergence of a condition (e.g., a particular seat at a game, concert, or the like) and allocate ownership to a specific owner based on upon the emergence of a condition that determines which prospective owner has the right to become the actual owner (e.g., that owner's team makes it to the game). In the example of a sports league, the blockchain can thus maintain as many owners as there are mutually exclusive conditions for a seat (e.g., by allocating seats across all teams in a conference for the Super Bowl, or all teams in a division for a college football conference final). The defined set of parameters may include location (where an as-yet-unscheduled event takes place), participants (teams, individuals, and many others), prices (such as the access token is priced below a defined threshold), timing (such as a span of hours, days, months, years, or other periods), type of event (sports, concerts, comedy performances, theatrical performances, political events, and many others) and others. In embodiments, one or more monitoring system layers 506 or other data collection systems may be configured to monitor one or more external marketplaces 590 or platform-operated marketplaces (such as on e-commerce websites and applications, auction sites and applications, social media sites and applications, exchange sites and applications, ticketing sites and applications, travel sites and applications, hospitality sites and applications, concert promotional sites and applications, or other sites or applications) or other entities for indicators of available events, for prospective conditions that can be used to define potentially divisible or mutually exclusive access right conditions (such as for identifying events that can be configured on a multi-party distributed ledger with conditional access distributed across different prospective owners, optionally conducted via one or more opportunity miners 646) and for actual conditions that may trigger distribution of rights to a specific owner based on the conditions. Thus, the blockchain may be used to make a contingent market in any form of event or access token by securely storing access rights on a distributed ledger, and the contingent market may be automated by configuring data collection and a set of business rules that operate upon collected data to determine when ownership rights should be vested, transferred, or the like. Post-vesting of a contingency (or set of contingencies), the access token may continue to be traded, with the blockchain providing a secure method of validating access. Security may be provided by encryption of the chain as with cryptocurrency tokens (and a cryptocurrency token may itself comprise a forward-market cryptocurrency token for event access), with proof of work, proof of stake, or other methods for validation in the case of disputes.

In embodiments, the platform 600 may include or interact with various applications, services, solutions or the like, such as those described in connection with the platform 500, such as pricing applications 621 (such as for setting and monitoring pricing for contingent access rights, underlying access rights, tokens, fees and the like), analytics solutions 619 (such as for monitoring, reporting, predicting, and otherwise analyzing all aspects of the platform 1200, such as to optimize offerings, timing, pricing, or the like, to recognize and predict patterns, to establish rules and contingencies, to establish models or understanding for use by humans or by machine learning system, and for many other purposes), trading applications 628 (such as for trading or exchanging contingent access rights or underlying access rights or tokens), security applications 618, or the like.

With reference to FIG. 12, in embodiments provided herein is a transactional, financial and marketplace enablement system. An example system may include an robotic process automation circuit structured in interpret information from a plurality of data sources, and to interface with a plurality of management applications; wherein the plurality of management applications are each associated with a separate one of a plurality of financial entities; and wherein the robotic process automation circuit further comprises an opportunity mining component structured to determine a robot operational process improvement for at least one of the plurality of management applications in response to the information from the plurality of data sources.

Certain further aspects of an example system are described following, any one or more of which may be present in certain embodiments. An example system may further include a data collection circuit structured to collect and record physical process observation data, wherein the physical process observation data is one of the plurality of data sources.

An example system may further include a data collection circuit structured to collect and record software interaction observation data, wherein the software interaction observation data is one of the plurality of data sources.

An example system may include wherein the plurality of management applications comprise at least two applications selected from the applications consisting of: a forward market application, an event access tokens application, a security application, a blockchain application, a platform marketplace application, an analytics application, a pricing application, and a smart contract application.

An example system may include wherein the plurality of data sources comprise at least two applications selected from the applications consisting of: an access data source, an asset and facility data source, a worker data source, a claims data source, an accounting data source, an event data source, and an underwriting data source.

An example system may include wherein the at least one entity each comprise an entity selected from the entities consisting of: an external marketplace, a banking facility, an insurance facility, a financial service facility, an operating facility, a collaborative robotics facility, a worker, a wearable device, an external process, and a machine.

An example system may include wherein the opportunity mining component is further structured to determine a plurality of process improvement opportunities for one of the plurality of management applications in response to the information from the plurality of data sources, and to provide one of a prioritized list or a visualization of the plurality of process improvement opportunities to the one of the plurality of management applications.

An example system may include wherein the opportunity mining component is further structured to determine a process improvement opportunity in response to at least one parameter selected from the parameters consisting of: a time saving value, a cost saving value, and an improved outcome value.

An example system may include wherein the plurality of management applications includes a trading management application, and wherein the robotic process automation circuit is further structured to automate a trading management process.

An example system may include wherein the robotic process automation circuit is further structured to automate the trading management process by performing at least one operation selected from the operations consisting of: utilizing data from the plurality of data sources to schedule a trading event; and determining trading criteria in response to a plurality of asset data and trading outcomes, and providing a trading command in response to the plurality of asset data and trading management outcomes.

An example system may include wherein the robotic process automation circuit is further structured to automate the trading management process in response to at least one of the plurality of data sources that is not accessible to the trading management application.

An example system may include wherein the robotic process automation circuit is further structured to improve the process at least one of the plurality of management applications by providing an output to at least one entity selected from the entities consisting of: an external marketplace, a banking facility, an insurance facility, a financial service facility, an operating facility, a collaborative robotics facility, a worker, a wearable device, an external process, and a machine.

An example system may include wherein the robotic process automation circuit is further structured to interpret an outcome from the at least one entity, and wherein the opportunity mining component is further structured to iteratively improve the process in response to the outcome from the at least one entity.

An example system may include wherein at least one of the plurality of data sources is not accessible to each of the at least one of the plurality of management applications having an improved process by the robotic process automation circuit.

An example system may include wherein the at least one of the plurality of management applications having an improved process by the robotic process automation circuit comprises a forward market application, and wherein the at least one of the plurality of data sources comprises at least one data source selected from the data sources consisting of: a claims data source, a pricing data source, an asset and facility data source, a worker data source, and an event data source.

An example system may include wherein the at least one of the plurality of management applications having an improved process by the robotic process automation circuit comprises an event access tokens management application, and wherein the at least one of the plurality of data sources comprises at least one data source selected from the data sources consisting of: an access data source, a pricing data source, an accounting data source, a worker data source, and an event data source.

An example system may include wherein the at least one of the plurality of management applications having an improved process by the robotic process automation circuit comprises a security management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic process automation circuit comprises a blockchain management application, and wherein the at least one of the plurality of data sources comprises at least one data source selected from the data sources consisting of: an asset and facility data source, a claims data source, a worker data source, an event data source, and an underwriting data source.

An example system may include wherein the at least one of the plurality of management applications having an improved process by the robotic process automation circuit comprises a pricing management application, and wherein the at least one of the plurality of data sources comprises at least one data source selected from the data sources consisting of: an asset and facility data source, a claims data source, a worker data source, and an event data source.

An example system may include wherein the at least one of the plurality of management applications having an improved process by the robotic process automation circuit comprises an analytics management application, and wherein the at least one of the plurality of data sources comprises at least one data source selected from the data sources consisting of: an access data source, a claims data source, a worker data source, and an event data source.

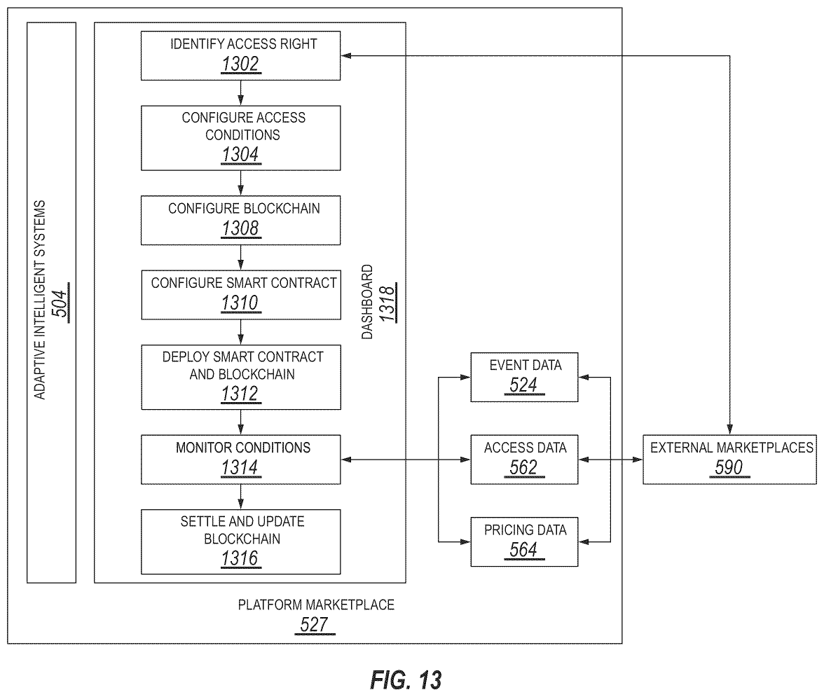

Referring to FIG. 13, a platform-operated marketplace 527 for a forward market to access rights to one or more events may be configured, such as in a dashboard 1318 or other user interface for an operator of the platform-operated marketplace 527, using the various enabling capabilities of the data handling transactional, financial and marketplace enablement system 500 described throughout this disclosure. The operator may use the user interface or dashboard 1318 to undertake a series of steps to perform or undertake an algorithm to create a contingent forward market event access right token as described in connection with FIG. 12. In embodiments, one or more of the steps of the algorithm to create a contingent forward market event access right token within the dashboard 1318 may include identifying one or more access rights for one or more events at a component 1302 to identify access rights, such as by monitoring one or more platform-operated marketplaces 527 or external marketplaces 590 for messages, announcements, or other data indicative of the event or access right. The dashboard 1318 may be configured with interface elements (including application programming elements) that allow the event to be imported into the platform-operated marketplace 527, such as by linking to the environment where the access right is offered or maintained, which may include using APIs for backend ticketing systems and the like. In the dashboard 1318, at a component 1304, one or more conditions (of the type described herein) for the access right may be configured (e.g., by interfacing with a user), such as by defining a set of mutually exclusive conditions that, upon triggering, allocate the access right to different individuals or entities. The user interface of the dashboard 1318 may include a set of drop-down menus, tables, forms, or the like with default, templated, recommended, or pre-configured conditions, such as ones that are appropriate for various types of access rights. For example, access rights to a playoff game for a sporting event can be preconfigured to set an access condition as the presence of a specific team in the playoff game, where the team is a member of the set of teams that could be in the game, and access rights are allocated to a given seat across mutually exclusive possible teams that could make it to the game (e.g., the teams in one conference for the Super Bowl). As another example, access rights to an as-yet-unplanned entertainment event could be preconfigured to set conditions such as a venue, a span of dates and a selected entertainer or group. Once the conditions and other parameters of the access rights are configured, at a component 1308 a blockchain may be configured to maintain, such as via a ledger, the data required to provision, allocate, and exchange ownership of the contingent access rights (and optionally the underlying access tokens to which the contingent access rights relate). For example, a ticket to a game may be stored as a cryptographically secure token on the ledger, and another token may be created and stored on the blockchain for each contingent access right that could result in the ownership of the ticket. The blockchain may be configured to store tokens, identity information, transaction information (such as for exchanges of contingent rights and/or underlying tokens) and other data. At a component 1310 a smart contract 631 may be configured to embody the conditions that were configured at the component 1304, and to operate on the blockchain that was created at the component 1308 as well as to operate on other data, such as data indicating facts, conditions, events, or the like in the platform-operated marketplace 527 and/or an external marketplace 590. The smart contract may be configured at a component 1310 to apply one or more rules, execute one or more conditional operations, or the like upon data that may include event data 524, access data 562, pricing data 564 or other data about or relevant to access rights. Once configuration of one or more blockchains and one or more smart contracts is complete, at a component 1312 the blockchain and smart contract may be deployed in the platform-operated marketplace, such as for interaction by one or more consumers or other users, who may, such as in a marketplace interface, such as a website, application, or the like, enter into the smart contract, such as by purchasing a contingent right to a future event, at which point the platform, such as using the adaptive intelligent systems layer 504 or other capabilities, may store relevant data, such as pricing data and identity data for the party or parties entering the smart contract on the blockchain or otherwise on the platform 500. At a component 1314, once the smart contract is executed, the component 1314 may monitor, such as by the monitoring systems layer 506, the platform-operated marketplace 527 and/or one or more external marketplaces 590 for event data 524, access data 562, pricing data 564 or other data, such as events, that may satisfy one or more conditions or trigger application of one or more rules of the smart contract. For example, results of games or announcements of future entertainment events may be monitored, and smart contract conditions may be satisfied. At a component 1316, upon satisfaction of conditions, smart contracts may be settled, executed, or the like, resulting updates or other operations on the blockchain, such as by transferring ownership of underlying access tokens and/or contingent access tokens. Thus, via operation of the above-referenced components, an operator of the platform-operated marketplace 527 may discover, configure, deploy, and have executed a set of smart contracts that offer and deliver contingent access to future events that are cryptographically secured and transferred on a blockchain to consumers or others. In embodiments, the adaptive intelligent systems layer 504 may be used to monitor the steps of the algorithm described above, and one or more artificial intelligence systems may be used to automated, such as by robotic process automation, the entire process or one or more sub-steps or sub-algorithms. This may occur as described above, such as by having an artificial intelligence system learn on a training set of data resulting from observations, such as monitoring software interactions, of human users as they undertake the above-referenced steps. Once trained, the adaptive intelligent systems layer 504 may thus enable the transactional, financial and marketplace enablement system 500 to provide a fully automated platform for discovery and delivery of contingent access rights to future events.

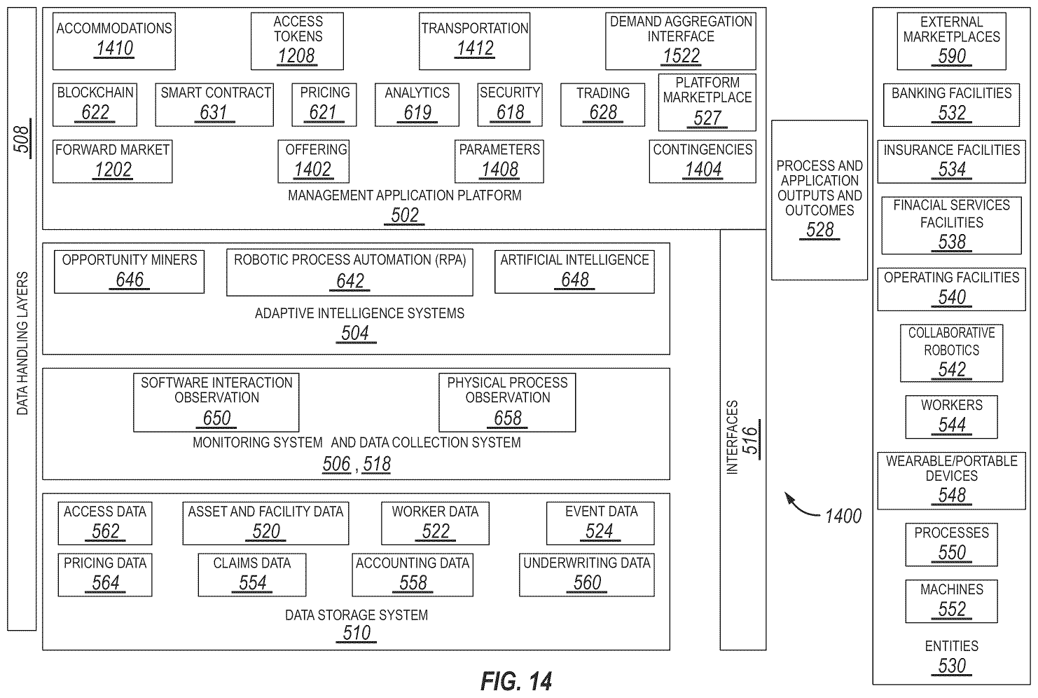

Referencing FIG. 14, in embodiments, a platform is provided herein, with systems, methods, processes, services, components and other elements for enabling a blockchain and smart contract platform for forward market demand aggregation 1202. In this case, a demand aggregation blockchain and smart contract platform 1400, having various features and enabled by capabilities similar to those described in connection with the transactional, financial and marketplace enablement system 500 and the platform 1200 as described above may be based on a set of contingencies 1404 that influence or represent future demand for an offering 1402, which may comprise a set of products, services, or the like (which may include physical goods, virtual goods, software, physical services, software, access rights, entertainment content, or many other items). A blockchain 622, such as enabling distributed ledger, may record indicators of interest from a set of parties with respect to the product, service, or the like, such as ones that define parameters under which the party is willing to commit to purchase the product or service. Interest may be expressed or committed in a demand aggregation interface 1522, which may be included in or associated with one or more sites, applications, communications systems, or the like, which may be independently operated or may comprise aspects of a platform-operated marketplace 527 or an external marketplace 590. Commitments may be taken and administered via a smart contract 631 or other transaction mechanisms. These commitments may include various parameters 1408, such as parameters of price, technical specification (e.g., shoe size, dress size, or the like for clothing, or performance characteristics for information technology, such as bandwidth, storage capacity, pixel density, or the like), timing, and many others for one or more desired offerings 1402. The blockchain 622 may thus be used to aggregate future demand in a forward market 1202 with respect to a variety of products and services and may be processed by manufacturers, distributors, retailers, and others to help plan for the demand, such as for assistance (optionally in an analytics system 619 with pricing, inventory management, supply chain management, smart manufacturing, just-in-time manufacturing, product design and many other activities). The offering 1402, whether a product, service, or other item, need not exist at the time a set of parameters 1408 are configured; for example, an individual can indicate a willingness to pay up to $1000 for a 65 inch, 32K quantum dot television display on or before Jan. 1, 2022. In embodiments, a vendor can offer a range of potential configurations and conditions with respect to which consumers can indicate interest, and optionally commit to purchase within defined conditions. In embodiments, consumers may present desired items and configurations. In embodiments, an artificial intelligence system, which may be a rule-based system, such as enabled by an adaptive intelligent systems layer 504, may process a set of potential configurations having different parameters 1408 for a subset of configurations that are consistent with each other (e.g., all have 4K or greater capability and all are priced below $500), and the subset of configurations may be used to aggregate committed future demand for the offering that satisfies a sufficiently large subset at a profitable price. In embodiments, the adaptive intelligent systems 404 may use a fuzzy logic system, a self-organizing map, or the like to group potential configurations, such that a human expert may determine a configuration that is near enough to ones that have been identified, such that it can be presented as a new alternative. In embodiments, an artificial intelligence system 648 may be trained to learn to determine and present new configurations for offerings 1402 based on a training data set created by human experts.

In embodiments, a platform 1400 is provided herein, with systems, methods, processes, services, components, and other elements for enabling a blockchain and smart contract platform for forward market rights for accommodations. An accommodation offering 1410 may comprise a combination of products, services, and access rights that may be handled as with other offerings, including aggregation demand for the offering 1410 in a forward market 1202. In embodiments, the forward market capabilities noted above may include access tokens 1208 for accommodations, as well as future accommodations, such as hotel rooms, shared spaces offered by individuals (e.g., Airbnb™ spaces), bed-and-breakfasts, workspaces, conference rooms, convention spaces, fitness accommodations, health and wellness accommodations, dining accommodations, and many others. Accommodations offerings 1410 may be linked to other access tokens 1208, such as in packages; for example, a hotel room in a city within walking distance of a sporting event may be linked by or on the same blockchain or linked blockchains (e.g., by linking ownership or access rights to both on the same ledger), so that when a condition is met (e.g., a fan's team makes it to the Super Bowl), vesting of ownership of the access token to the event also automatically establishes (and optionally automatically initiates, such as via an application programming interface of the platform) the right to the accommodation (such as by booking a hotel room and dining reservations). Thus, the forward market for the event may enable a convenient, secure forward market, enabled by automatic processing on the blockchain for packages of event access tokens, accommodations, and other elements. In embodiments, accommodations may be provided with configured forward market parameters 1408 (including conditional parameters) apart from access tokens 1208 to events, such as where a hotel room or other accommodation is booked in advance upon meeting a certain condition (such as one relating to a price within a given time window). For example, an accommodation offering 1410 at a four-star hotel during a music festival could be pre-configured to be booked if and when the accommodation (e.g., a room with a king bed and a city view) becomes available within a given time window. Thus, demand for accommodations can be aggregated in advance and conveniently fulfilled by automatic recognition (such as by monitoring systems 506) of conditions that satisfy pre-configured commitments represented on a blockchain (e.g., distributed ledger) and automatic initiation (optionally including by smart contract execution) of settlement or fulfillment of the demand (such as by automated booking of a room or other accommodations).

In embodiments, a platform is provided herein, with systems, methods, processes, services, components, and other elements for enabling a blockchain and smart contract platform for forward market rights to transportation. As with accommodations, transportation offerings 1412 may be aggregated and fulfilled, with a wide range of pre-defined contingencies, using the platform 1400. As with accommodations offerings 1410, transportation offerings 1412 can be linked to other access tokens 1208 (such as event tickets, accommodations, services, and the like), such as where a flight is automatically booked at or below a predefined price threshold if and when the fan's team makes it to the Super Bowl, among many other examples. Transportation offerings 1412 can also be offered separately (such as where travel is automatically booked based on a commitment, in a distributed ledger, to buy a ticket if it is offered within a given time window at a given price). As with other goods and services, aggregation on the blockchain 622, such as a distributed ledger, can be used for demand planning, for determining what resources are deployed to what routes or types of travel, and the like. Transportation offerings 1412 can be configured, with predefined contingencies 1404 and parameters 1408, such as with respect to price, mode of transportation (air, bus, rail, private car, ride share or other), level of service (e.g., First Class, business class, or other), mode of payment (e.g., use of loyalty programs, rewards points, or particular currencies, including cryptocurrencies), timing (e.g., defined time period or linked to an event, location (e.g., specified to be where a given type of event takes place (such as this year's Super Bowl) or a specific location), route (e.g., direct or multi-stop, from the destination of the consumer to a specific location or to wherever an event takes place), and many others.

In embodiments, the platform 1400 may include or interact with various applications, services, solutions or the like, such as those described in connection with the platform 500, such as pricing applications 621 (such as for setting and monitoring pricing for goods, services, access rights, tokens, fees and other items), analytics solutions 619 (such as for monitoring, reporting, predicting, and otherwise analyzing all aspects of the platform 1200, such as to optimize offerings, timing, pricing, or the like, to recognize and predict patterns, to establish rules and contingencies, to establish models or understanding for use by humans or by machine learning system, and for many other purposes), trading applications 628 (such as for trading or exchanging contingent access rights, futures or options for goods, services, or other offerings 1402, tokens and other items), security applications 618, or the like.

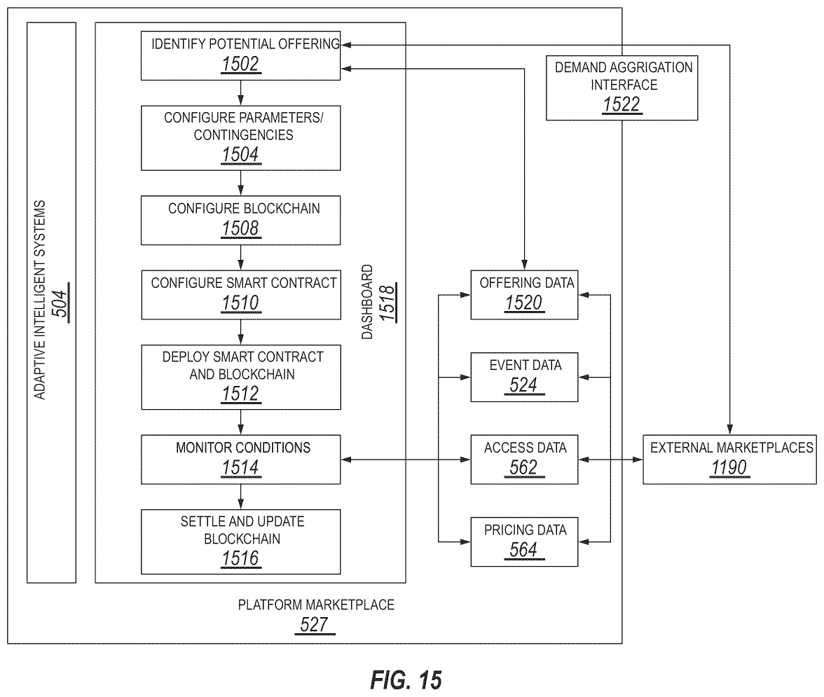

Referring to FIG. 15, a platform-operated marketplace 527 for a forward market to future offerings 1402 may be configured, such as in a dashboard 1518 or other user interface for an operator of the platform-operated marketplace 527, using the various enabling capabilities of the data handling platform 500 described throughout this disclosure. The operator may use the user interface or dashboard 1518 to undertake a series of steps to perform or undertake an algorithm to create an offering 1410 as described in connection with FIG. 14. In embodiments, one or more of the steps of the algorithm to create a contingent future offering 1410 within the dashboard 1518 may include, at a component 1502, identifying offering data 1520, which may come from a platform-operated marketplace 527 or an external marketplace 590, such as via a demand aggregation interface 1522 presented to one or more consumers within one of them, or may be entered via a user interface of or at a site or application that is created for demand aggregation for offerings 1410, such as via solicitation of consumer interest or consumer commitments (such as commitments entered into by smart contracts) based on specification of various possible parameters 1408 and contingencies 1404 for such offerings 1410.

The dashboard 1518 may be configured with interface elements (including application programming elements) that allow an offering to be managed in the platform-operated marketplace 527, such as by linking to the set of environments where various components of the offering 1402, such as descriptions of goods and services, prices, access rights and the like are specified, offered or maintained, which may include using APIs for backend ticketing systems, e-commerce systems, ordering systems, fulfillment systems, and the like. In the dashboard 1518, a component 1504 may configure one or more parameters 1408 or contingencies 1404 (e.g., via interactions with a user), such as comprising or describing the conditions (of the type described herein) for the offering, such as by defining a set of conditions that trigger the commitment by a consumer to partake of the offering 1402, that trigger the right to an allocation of the offering, or the like. The user interface of the dashboard 1518 may include a set of drop down menus, tables, forms, or the like with default, templated, recommended, or pre-configured conditions, parameters 1408, contingencies 1404 and the like, such as ones that are appropriate for various types of offerings 1402. For example, access rights to a new line of shoes can be preconfigured to set an offering condition as the offering of a shoe by a certain designer of a certain style and color and may be preconfigured to accept a commitment to buy the shoe if the access is provided below a certain price during a certain time period. As another example, demand for an as-yet-unplanned entertainment event can be preconfigured to set conditions such as a venue, a span of dates and a selected entertainer or group. Once the conditions and other parameters of the offering 1402 are configured, a component 1508 may configure a blockchain to maintain, such as via a ledger, the data required to provision, allocate, and exchange ownership of items comprising the offering (and optionally underlying access tokens, virtual goods, digital content items, or the like that are included in or associated with the offering). For example, a virtual good for a video may be stored as a cryptographically secure token on the ledger, and another token may be created and stored on the blockchain for each contingent access right that could result in the ownership of the virtual good or each smart contract to purchase the virtual good if and when it becomes available under defined conditions. The blockchain may be configured to store tokens, identity information, transaction information (such as for exchanges of contingent rights and/or underlying tokens), virtual goods, license keys, digital content, entertainment content, and other data. A component 1510 may configure a smart contract 631 to embody the conditions that were configured at the component 1504 and to operate on the blockchain that was created at the component 1508 as well as to operate on other data, such as data indicating facts, conditions, events, or the like in the platform-operated marketplace 527 and/or an external marketplace 590. The smart contract may be configured at the step 1510 to apply one or more rules, execute one or more conditional operations, or the like upon data that may include offering data 1520, event data 524, access data 562, pricing data 564 or other data about or relevant to a set of offerings 1402. Once configuration of one or more blockchains and one or more smart contracts is complete, at a component 1512 the blockchain and smart contract may be deployed in the platform-operated marketplace 527, such as for interaction by one or more consumers or other users, who may, such as in a marketplace interface or a demand aggregation interface 1522, such as a website, application, or the like, enter into the smart contract, such as by executing an indication of a commitment to purchase, attend, or otherwise consume the future offering 1402, at which point the platform, such as using the adaptive intelligent systems layer 504 or other capabilities, may store relevant data, such as pricing data and identity data for the party or parties entering the smart contract on the blockchain or otherwise on the platform 500. At a component 1514, once the smart contract is executed, the platform may monitor, such as by the monitoring systems layer 506, the platform-operated marketplace 527 and/or one or more external marketplaces 590 for offering data 1520, event data 524, access data 562, pricing data 564 or other data, such as events, that may satisfy one or more conditions or trigger application of one or more rules of the smart contract. For example, announcements of offerings may be monitored, such as on e-commerce sites, auction sites, or the like, and smart contract conditions may be satisfied by one or more of the offerings 1402.

At a component 1516, upon satisfaction of conditions, smart contracts may be settled, executed, or the like, resulting updates or other operations on the blockchain, such as by transferring ownership of goods, services, underlying access tokens and/or contingent access tokens and transferring required consideration (such as obtained by a payments system). Thus, via the above-referenced steps, an operator of the platform-operated marketplace 527 may discover, configure, deploy, and have executed a set of smart contracts that aggregate demand for, and offer and deliver contingent access to, offerings 1402 that are cryptographically secured and transferred on a blockchain to consumers or others. In embodiments, the adaptive intelligent systems layer 504 may be used to monitor the steps of the algorithm described above, and one or more artificial intelligence systems may be used to automated, such as by robotic process automation, the entire process or one or more sub-steps or sub-algorithms. This may occur as described above, such as by having an artificial intelligence system learn on a training set of data resulting from observations, such as monitoring software interactions, of human users as they undertake the above-referenced steps. Once trained, the adaptive intelligent systems layer 504 may thus enable the platform 500 to provide a fully automated platform for discovery and delivery of offerings, as well as demand aggregation for such offerings 1402 and automated handling of access to and ownership of such offerings 1402.

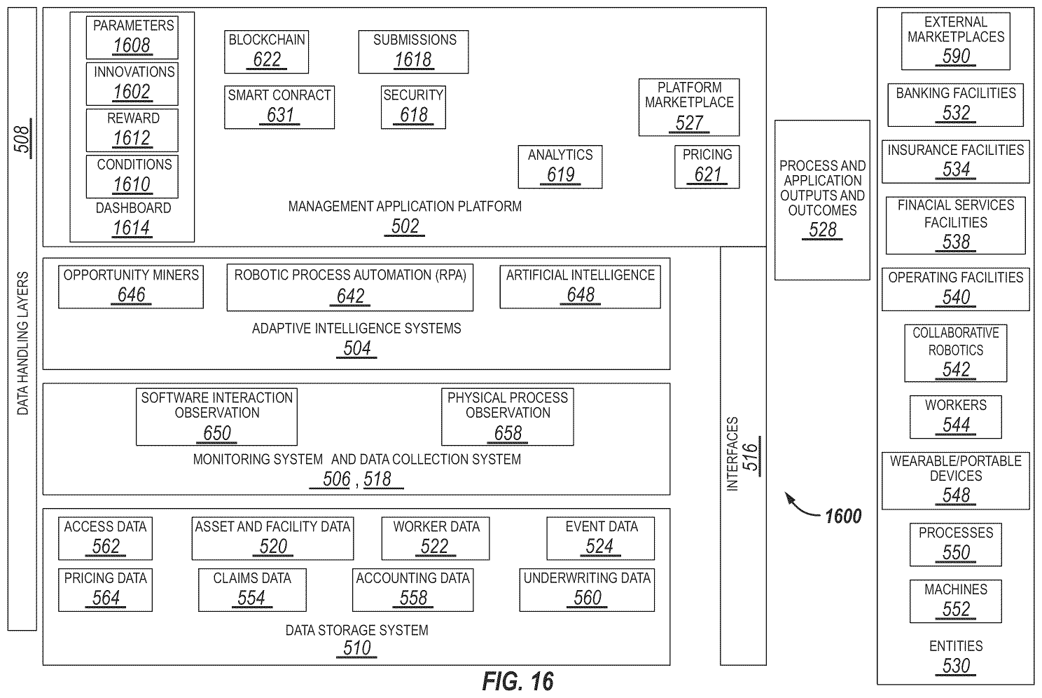

Referring to FIG. 16, in embodiments, a platform is provided herein, with systems, methods, processes, services, components and other elements for enabling a blockchain and smart contract platform 1600 for crowdsourcing for innovation. In such embodiments, a party seeking a set of innovations 1602, such as inventions, works of authorship, innovations, technology solutions to a set of problems, satisfaction of a technical specification, or other advancement may configure, such as on a blockchain 622 (optionally comprising a distributed ledger), a set of conditions 1610, capable of being expressed in a smart contract 631, that are required to satisfy the requirement. A reward 1612 may be configured for generating an innovation 1602 of a given set of capabilities or satisfying a given set of parameters 1608 by a given date (e.g., a technical specification for a 5G foldable phone that can be produced for less than $100 per unit before the end of 2019). Satisfaction of the conditions 1610 may be measured by a monitoring system 506, by one or more experts, or by a trained artificial intelligence system 648 (such as one trained to evaluate responses based on a training set created by experts). In embodiments, the blockchain and smart contract platform 1600 may include a dashboard 1614 for configuration of the specification, requirements or other conditions 1610, the reward 1612, timing and other parameters 1608 (such as any required qualifications, formats, geographical requirements, certifications, credentials, or the like that may be required of a submission or a submitter), and the blockchain and smart contract platform 1600 may automatically configure a blockchain 622 to store the parameters 1608 and a smart contract 631 to operate, such as in coordination with a website, application, or other marketplace environments, to offer the reward 1612, receive and record submissions 1618 (such as on the blockchain 622), allocate rewards 1612, and the like, with events, transactions, and activities being recorded in blockchain, optionally using a distributed ledger. In embodiments, rewards 1612 may be configured to be allocated across multiple submissions, such as where an innovation requires solution of multiple problems, such that submissions 1618 may be evaluated for satisfaction of some conditions and rewards may be allocated among contributing submissions 1618 when and if a complete solution (comprising aggregation of multiple submissions 1618) is achieved, unlocking the reward, at which point the contributing submissions 1618 recorded on the distributed ledger may be allocated appropriate portions of the reward. Submissions may include software, technical data, know how, algorithms, firmware, hardware, mechanical drawings, prototypes, proof-of-concept devices, systems, and many other forms, which may be identified, described, or otherwise documented on the blockchain 622 (e.g., distributed ledger), such as by one or more links to one or more resources (which may be secured by cryptographic or other techniques). Submissions may thus be described and evaluated for purposes of allocation of rewards 1612 (such as by one or more independent experts, by artificial intelligence systems (which may be trained by experts) or the like), then locked, such as by encryption, secure storage, or the like, unless and until a reward is distributed via the distributed ledger. Thus, the platform provides a secure system for exchange of information related to innovation that is provided for rewards, such as in crowdsourcing or other innovation programs. An artificial intelligence system 648 may be trained, such as by a training set of data using interactions of experts with submissions 1618, to automatically evaluate submissions 1618, for either automatic allocation of rewards or to pre-populate evaluation for confirmation by human experts. In embodiments, an artificial intelligence system 648 may be trained, such as by a training set of data reflecting expert interactions with the dashboard 1614, optionally coupled with outcome information, such as from analytics system 619, to create rewards 1612, set conditions 1610, specify innovations 1602, and set other parameters 1608, thereby providing a fully automated or semi-automated capability for one or more of those capabilities.

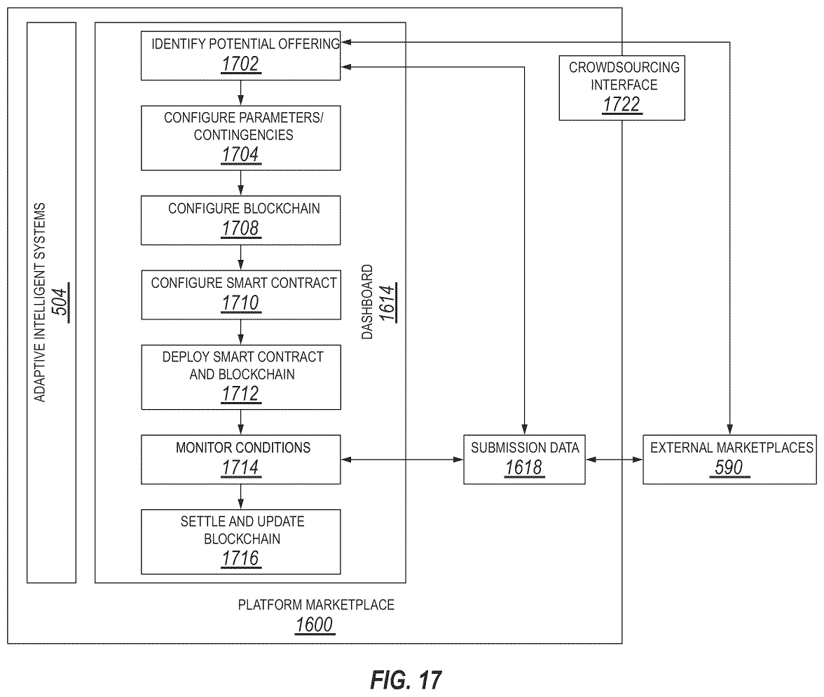

Referring to FIG. 17, a platform-operated marketplace 527 for crowdsourcing innovation 1602 may be configured, such as in a crowdsourcing dashboard 1614 or other user interface for an operator of the platform-operated marketplace 527, using the various enabling capabilities of the data handling platform 500 described throughout this disclosure. The operator may use the user interface or crowdsourcing dashboard 1614 to undertake a series of steps to perform or undertake an algorithm to create crowdsourcing offers as described in connection with FIG. 16. In embodiments, one or more of the components depicted are configured to create a reward 1612 within the dashboard 1614 which may include, at a component 1702, identifying potential offers, such as what innovations 1602 are of interest (such as may be indicated by indications of demand in a platform-operated marketplace 527 or an external marketplace 590, or by indications by stakeholders for an enterprise through various communication channels).

The dashboard 1614 may be configured with a crowdsourcing interface 1712, such as with elements (including application programming elements) that allow a crowdsourcing offering to be managed in the platform-operated marketplace 527 and/or in one or more external marketplaces 590. In the dashboard 1614, at a component 1704, the user may configure one or more parameters 1608 or conditions 1610, such as comprising or describing the conditions (of the type described herein) for the crowdsourcing offer, such as by defining a set of conditions 1610 that trigger the reward 1612 and determine allocation of the reward 1612 to a set of submitters. The user interface of the dashboard 1614 may include a set of drop-down menus, tables, forms, or the like with default, templated, recommended, or pre-configured conditions, parameters 1608, conditions 1610 and the like, such as ones that are appropriate for various types of crowdsourcing offers. Once the conditions and other parameters of the offer are configured, at a component 1708, a smart contract 631 and blockchain 622 may be configured to maintain, such as via a ledger, the data required to provision, allocate, and exchange data related to the offer. The blockchain may be configured to store tokens, identity information, transaction information (such as for exchanges of information), technical descriptions, virtual goods, license keys, digital content, entertainment content, and other data, content or information that may be relevant to a submission 1618 or a reward 1612. At a component 1710, a smart contract 631 may be configured to embody the conditions that were configured at the step 1704 and to operate on the blockchain that was created at the component 1708 as well as to operate on other data, such as data indicating facts, conditions, events, or the like in the platform-operated marketplace 527 and/or an external marketplace 590, such as ones related to submission data 1618. The smart contract 631 may be responsive to the component 1710 to apply one or more rules, execute one or more conditional operations or the like upon data, such as submission data 1618 and data indicating satisfaction of parameters or conditions, as well as identity data, transactional data, timing data, and other data. Once configuration of one or more blockchains and one or more smart contracts is complete, at a component 1712, the blockchain and smart contract may be deployed in the platform-operated marketplace 527, external marketplace 590 or other environment, such as for interaction by one or more submitters or other users, who may, such as in a crowdsourcing interface 1712, such as a website, application, or the like, enter into the smart contract, such as by submitting a submission 1618 and requesting the reward 1612, at which point the platform, such as using the adaptive intelligent systems layer 504 or other capabilities, may store relevant data, such as submission data 1618, identity data for the party or parties entering the smart contract on the blockchain, or otherwise on the platform 500. At a component 1714, once the smart contract is executed, the platform may monitor, such as by the monitoring systems layer 506, the platform-operated marketplace 527 and/or one or more external marketplaces 590 for submission data 1618, event data 524, or other data that may satisfy or indicate satisfaction of one or more conditions 1610 or trigger application of one or more rules of the smart contract 631, such as to trigger a reward 1612.

At a component 1716, upon satisfaction of conditions, smart contracts may be settled, executed, or the like, resulting in updates or other operations on the blockchain 622, such as by transferring consideration (such as via a payments system) and transferring access to submissions 1618. Thus, via the above-referenced steps, an operator of the platform-operated marketplace 527 may discover, configure, deploy, and have executed a set of smart contracts that crowdsource innovations that are cryptographically secured and transferred on a blockchain from innovators to parties seeking innovation. In embodiments, the adaptive intelligent systems layer 504 may be used to monitor the steps of the algorithm described above, and one or more artificial intelligence systems may be used to automate, such as by robotic process automation, the entire process or one or more sub-steps or sub-algorithms. This may occur as described above, such as by having an artificial intelligence system learn on a training set of data resulting from observations, such as monitoring software interactions of human users as they undertake the above-referenced steps. Once trained, the adaptive intelligent systems layer 504 may thus enable the platform 500 to provide a fully automated platform for crowdsourcing of innovation.

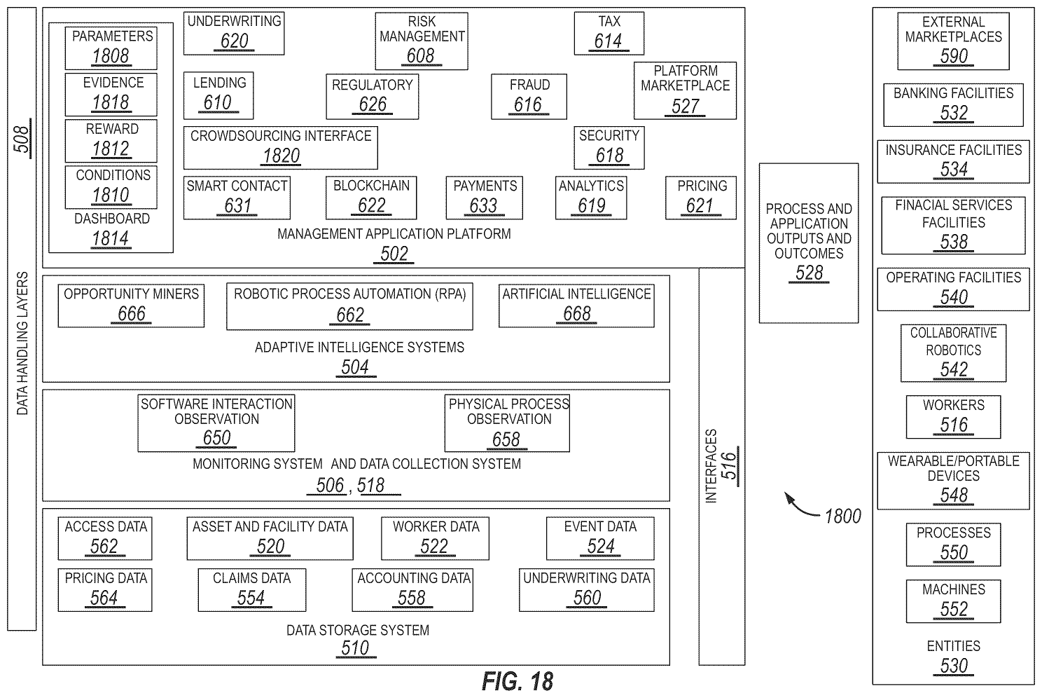

Referring to FIG. 18, in embodiments, a platform is provided herein, with systems, methods, processes, services, components and other elements for enabling a blockchain and smart contract platform 1800 for crowdsourcing for evidence. As with other embodiments described above in connection with sourcing innovation, product demand, or the like, a blockchain 622, such as optionally embodying a distributed ledger, may be configured with a set of smart contracts 631 to administer a reward 1812 for the submission of evidence 1818, such as evidence of infringement, evidence of prior art, evidence of publication, evidence of use, evidence of commercial sales, evidence of fraud, evidence of false statements, evidence of trespassing, evidence of negligence, evidence of misrepresentation, evidence of slander or libel, evidence of undertaking illegal activities, evidence of undertaking risky activities, evidence of omissions, evidence of breach of contract, evidence of torts, evidence of criminal conduct, evidence of regulatory violations, evidence of non-compliance with policies or procedures, evidence of the location of an individual (optionally including known or preferred locations), evidence of a social network or other relationship of an individual, evidence of a business connection of an individual or business, evidence of an asset of an individual or business, evidence of defects, evidence of harm, evidence of counterfeiting, evidence of identity (such as DNA, fingerprinting, video, photography or the like), evidence of damage, evidence of confusion (such as in cases of trademark infringement) or other evidence that may be relevant to a civil or criminal legal proceeding, a contract enforcement or negotiation, an arbitration or mediation, a hearing, or other proceeding. In embodiments, a blockchain 622, such as optionally distributed in a distributed ledger, may be used to configure a request for evidence 1818 (which may be a formal legal request, such as a subpoena, or an alternative form of request, such as in a fact-gathering situation), along with terms and conditions 1810 related to the evidence, such as a reward 1812 for submission of the evidence 1818, a set of terms and conditions 1810 related to the use of the evidence 1818 (such as whether it may only be released under subpoena, whether the submitting party has a right to anonymity, the nature of proceedings in which the evidence can be used, the permitted conditions for use of the evidence 1818, and the like), and various parameters 1808, such as timing parameters, the nature of the evidence required (such as scientifically validated evidence like DNA or fingerprints, video footage, photographs, witness testimony, or the like), and other parameters 1808.

The platform 1800 may include a crowdsourcing interface 1820, which may be included in or provided in coordination with a website, application, dashboard, communications system (such as for sending emails, texts, voice messages, advertisements, broadcast messages, or other messages), by which a message may be presented in the interface 1820 or sent to relevant individuals (whether targeted, such as in the case of a subpoena, or broadcast, such as to individuals in a given location, company, organization, or the like) with an appropriate link to the smart contract 631 and associated blockchain 622, such that a reply message submitting evidence 1818, with relevant attachments, links, or other information, can be automatically associated (such as via an API or data integration system) with the blockchain 622, such that the blockchain 622, and any optionally associated distributed ledger, maintains a secure, definitive record of evidence 1818 submitted in response to the request. Where a reward 1812 is offered, the blockchain 622 and/or smart contract 631 may be used to record time of submission, the nature of the submission, and the party submitting, such that at such time as a submission satisfies the conditions for a reward 1812 (such as, for example, upon apprehension of a subject in a criminal case or invalidation of a patent upon use of submitted prior art, among many other examples), the blockchain 622 and any distributed ledger stored thereby can be used to identify the submitter and, by execution of the smart contract 631, convey the reward 1812 (which may take any of the forms of consideration noted throughout this disclosure). In embodiments, the blockchain 622 and any associated ledger may include identifying information for submissions of evidence 1818 without containing actual evidence 1818, such that information may be maintained secret (such as being encrypted or being stored separately with only identifying information), subject to satisfying or verifying conditions for access (such as a legal subpoena, a warrant, or other identification or verification of a person who has legitimate access rights, such as by an identity or security application 618). Rewards 1812 may be provided based on outcomes of cases or situations to which evidence 1818 relates, based on a set of rules (which may be automatically applied in some cases, such as using a smart contract 631 in concert with an automation system, a rule processing system, an artificial intelligence system 648 or other expert system, which in embodiments may comprise one that is trained on a training data set created with human experts). For example, a machine vision system may be used to evaluate evidence of counterfeiting based on images of items, and parties submitting evidence of counterfeiting may be rewarded, such as via tokens or other consideration, via distribution of rewards 1812 through the smart contract 631, blockchain 622 and any distributed ledger. Thus, the platform 1800 may be used for a wide variety of fact-gathering and evidence-gathering purposes, to facilitate compliance, to deter improper behavior, to reduce uncertainty, to reduce asymmetries of information, or the like.

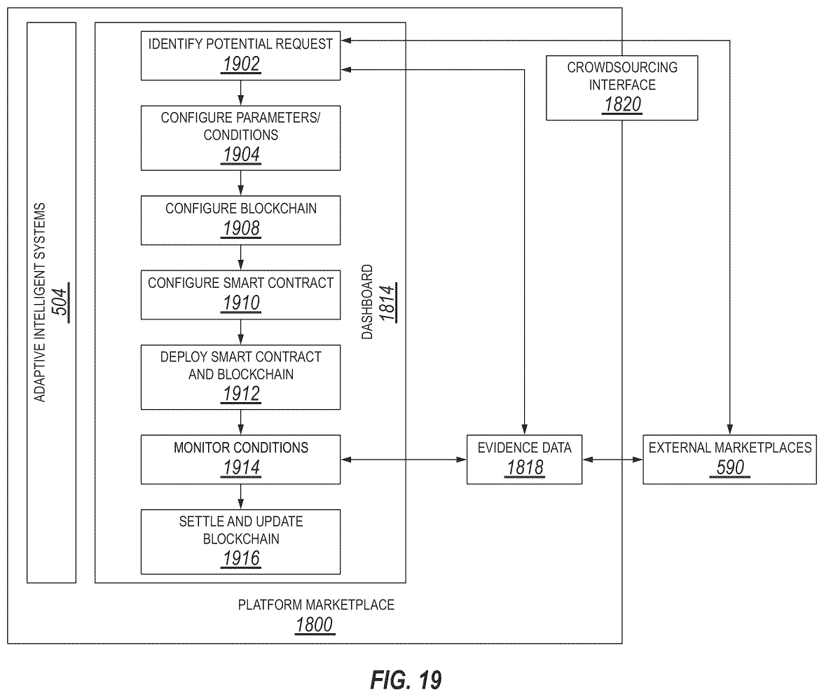

Referring to FIG. 19, a platform-operated marketplace crowdsourcing evidence 1800 may be configured, such as in a crowdsourcing interface 1820 or other user interface for an operator of the platform-operated marketplace 1800, using the various enabling capabilities of the data handling platform 500 described throughout this disclosure. The operator may use the user interface 1820 or crowdsourcing dashboard 1814 to undertake a series of steps to perform or undertake an algorithm to create a crowdsourcing request for evidence 1818 as described in connection with FIG. 18. In embodiments, one or more interactions with the components to create a reward 1812 within the dashboard 1814 may include, at a component 1902, identifying potential rewards 1812, such as what evidence 1818 is likely to be of value in a given situation (such as may be indicated through various communication channels by stakeholders or representatives of an entity, such as an individual or enterprise, such as attorneys, agents, investigators, parties, auditors, detectives, underwriters, inspectors, and many others).

The dashboard 1814 may be configured with a crowdsourcing interface 1820, such as with elements (including application programming elements, data integration elements, messaging elements, and the like) that allow a crowdsourcing request to be managed in the platform marketplace 1800 and/or in one or more external marketplaces 590. In the dashboard 1814, at a component 1904, the user may configure one or more parameters 1808 or conditions 1810, such as comprising or describing the conditions (of the type described herein) for the crowdsourcing request, such as by defining a set of conditions 1810 that trigger the reward 1812 and determine allocation of the reward 1812 to a set of submitters of evidence 1818. The user interface of the dashboard 1814, which may include or be associated with the crowdsourcing interface 1820, may include a set of drop down menus, tables, forms, or the like with default, templated, recommended, or pre-configured conditions, parameters 1808, conditions 1810 and the like, such as ones that are appropriate for various types of crowdsourcing requests. Once the conditions and other parameters of the request are configured, at a component 1908, a smart contract 631 and blockchain 622 may be configured to maintain, such as via a ledger, the data required to provision, allocate, and exchange data related to the request and to submissions of evidence 1818. The smart contract 631 and blockchain 622 may be configured to identity information, transaction information (such as for exchanges of information), technical information, other evidence data 1818 of the type described in connection with FIG. 18, including any data, testimony, photo or video content or other information that may be relevant to a submission of evidence 1818, or the conditions 1810 for a reward 1812. At a component 1910, a smart contract 631 may be configured to embody the conditions 1810 that were configured at the component 1904 and to operate on the blockchain 622 that was created at the component 1908, as well as to operate on other data, such as data indicating facts, conditions, events, or the like in the platform-operated marketplace 1800 and/or an external marketplace 590 or other information site or resource, such as ones related to submission of evidence data 1818, such as sites indicating outcomes of legal cases or portions of cases, sites reporting on investigations, and the like. The smart contract 631 may be responsive to apply one or more rules configured at component 1910, to execute one or more conditional operations or the like upon data, such as evidence data 1818 and data indicating satisfaction of parameters 1808 or conditions 1810, as well as identity data, transactional data, timing data, and other data. Once configuration of one or more blockchains 622 and one or more smart contracts 631 is complete, at a component 1912, the blockchain 622 and smart contract 631 may be deployed in the platform-operated marketplace 1800, external marketplace 590 or other site or environment, such as for interaction by one or more submitters or other users, who may, such as in a crowdsourcing interface 1820, such as a website, application, or the like, enter into the smart contract 631, such as by submitting a submission of evidence 1818 and requesting the reward 1812, at which point the platform 1800, such as using the adaptive intelligent systems layer 504 or other capabilities, may store relevant data, such as submitted evidence data 1818, identity data for the party or parties entering the smart contract 631 on the blockchain 622, or otherwise on the platform 1800. At a component 1914, once the smart contract 631 is executed, the platform 1800 may monitor, such as by the monitoring systems layer 506, the platform-operated marketplace 1800 and/or one or more external marketplaces 590 or other sites for submitted evidence data 1818, event data 524, or other data that may satisfy or indicate satisfaction of one or more conditions 1810 or trigger application of one or more rules of the smart contract 631, such as to trigger a reward 1812.

At a component 1916, upon satisfaction of conditions 1810, smart contracts 631 may be settled, executed, or the like, resulting in updates or other operations on the blockchain 622, such as by transferring consideration (such as via a payment system) and transferring access to evidence 1818. Thus, via the above-referenced steps, an operator of the platform-operated marketplace 1800 may discover, configure, deploy, and have executed a set of smart contracts 631 that crowdsource evidence and that are cryptographically secured and transferred on a blockchain 622 from evidence gatherers to parties seeking evidence. In embodiments, the adaptive intelligent systems layer 504 may be used to monitor the steps of the algorithm described above, and one or more artificial intelligence systems may be used to automate, such as by robotic process automation 642, the entire process or one or more sub-steps or sub-algorithms. This may occur as described above, such as by having an artificial intelligence system 648 learn on a training set of data resulting from observations, such as monitoring software interactions of human users as they undertake the above-referenced steps. Once trained, the adaptive intelligent systems layer 504 may thus enable the platform 500 to provide a fully automated platform for crowdsourcing of evidence.

In embodiments, evidence may relate to fact-gathering or data-gathering for a variety of applications and solutions that may be supported by a marketplace platform 500, including the evidence crowdsourcing platform 1800, such as for underwriting 620 (e.g., of insurance policies, loans, warranties, guarantees, and other items), including actuarial processes; risk management solutions 608 (such as managing a wide variety of risks noted throughout this disclosure); tax solutions (such as relating to evidence supporting deductions and tax credits, among others); lending solutions 610 (such as evidence of the ownership and or value of collateral, evidence of the veracity of representations, and the like); regulatory solutions 626 (such as with respect to compliance with a wide range of regulations that may govern entities 530 and processes, behaviors or activities of or by entities 530); and fraud prevention solutions 616 (such as to detect fraud, misrepresentation, improper behavior, libel, slander, and the like).

Evidence gathering may include evidence gathering with respect to entities 530 and their identities, assertions, claims, actions, or behaviors, among many other factors and may be accomplished by crowdsourcing in the crowdsourcing platform 1800 or by data collection systems 518 and monitoring systems 506, optionally with automation via process automation 642 and adaptive intelligence, such as using an artificial intelligence system 648.

In embodiments, the evidence gathering platform, whether a crowdsourcing platform 1800 or a more general data collection platform 500 that may or may not encompass crowdsourcing, is provided herein, with systems, methods, processes, services, components, and other elements for enabling a blockchain and smart contract platform for aggregating identity and behavior information for insurance underwriting 620. In embodiments, a blockchain, with an optional distributed ledger, may be used to record a set of events, transactions, activities, identities, facts, and other information associated with an underwriting process 620, such as identities of applicants for insurance, identities of parties that may be willing to offer insurance, information regarding risks that may be insured (of any type, such as property, life, travel, infringement, health, home, commercial liability, product liability, auto, fire, flood, casualty, retirement, unemployment and many others traditionally insured by insurance policies, in addition to a host of other types of risks that are not traditionally insured), information regarding coverage, exclusions, and the like, information regarding terms and conditions, such as pricing, deductible amounts, interest rates (such as for whole life insurance) and other information. The blockchain 622 and an associated smart contract 631 may, in coordination with or via a website, application, communications system, message system, marketplace, or the like, be used to offer insurance and to record information submitted by applicants, so that an insurance application has a secure, canonical record of submitted information, with access control capabilities that permit only authorized parties, roles and services to access submitted information (such as governed by policies, regulations, and terms and conditions of access). The blockchain 622 may be used in underwriting 620, such as by recording information (including evidence as noted in connection with evidence gathering above) that is relevant to pricing, underwriting, coverage, and the like, such as collected by underwriters, submitted by applicants, collected by artificial intelligence systems 648, or submitted by others (such as in the case of crowdsourcing platform 1800). In embodiments, the blockchain 622, smart contract 631 and any distributed ledger may be used to facilitate offering and underwriting of microinsurance, such as for defined risks related to defined activities for defined time periods that are narrower than for typical insurance policies. For example, insurance related to adverse weather events may be obtained for the day of a wedding. The blockchain 622 may facilitate allocation of risk and coordination of underwriting activities for a group of parties, such as where a group of parties agree to take some fraction of the risk, as recorded in the ledger. For example, the ledger may allow a party to take any fraction of the risk, thereby accumulating partial insurance unless and until a risk is fully covered as the rest of accumulation and aggregation of multiple parties agreeing, as recorded on the ledger, to insure an activity, a risk, or the like. The ledger may be used to allocate payments upon occurrence of the covered risk event. In embodiments, an artificial intelligence system 648 may be used to collect and analyze underwriting data, such as one that is trained by human expert underwriters. In embodiments, an automated system 642, such one using artificial intelligence 648, such as one trained to recognized and validate events, can be used to determine that an event has happened (e.g., a roof has collapsed, a car has been damage, or the like), such as from videos, images, sensors, IoT devices, witness submissions (such as over social networks), or the like, such that an operation on the distributed ledger may be initiated to pay out the insured amount, including initiating appropriate debits and credits that reflect transfer of funds from the underwriting/insuring parties to the insured. Thus, a blockchain-based ledger may simplify and automate much of the insurance process by reliably validating identities, maintaining confidentiality of information as needed, automatically accumulating evidence needed for pricing and underwriting, automatically processing information indicating occurrence of insured events, and automatically settling and fulfilling contracts upon occurrence of validated events.

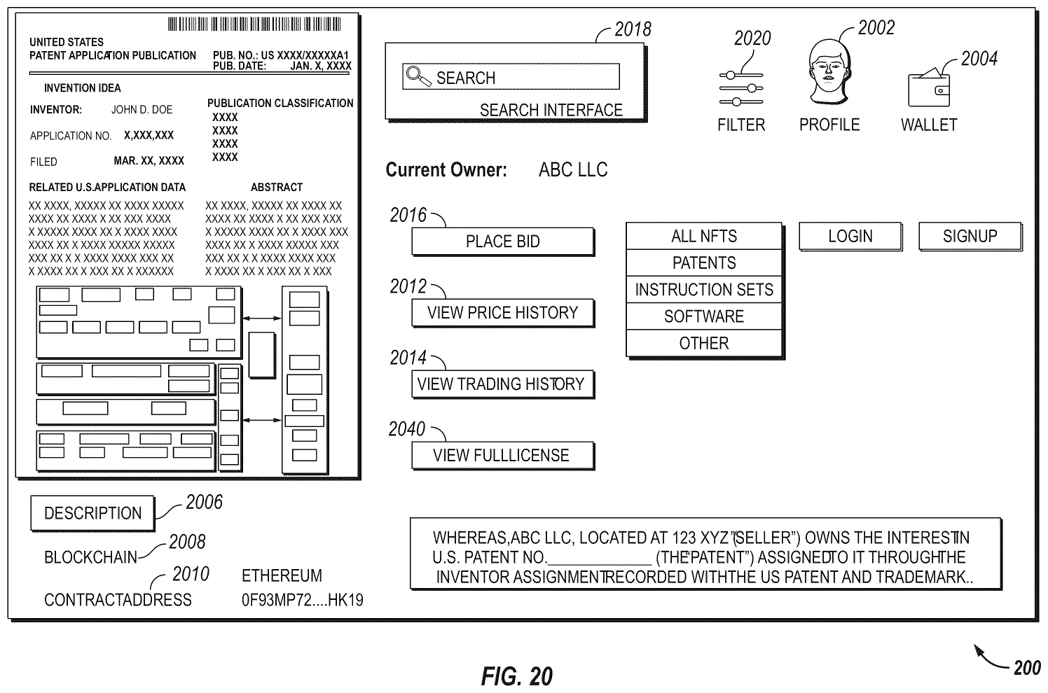

FIG. 20 is a diagrammatic view illustrating an example user interface of a digital marketplace configured to enable transactions and commerce between various users of a knowledge distribution system. User interface 2000 may be a web interface allowing an owner of an intellectual property to offer the intellectual property for licensing in the form of a non-fungible token (NFT) signifying some percentage of ownership rights associated with the intellectual property. In the example, the intellectual property is a US patent application. The owner of the patent application ABC LLC may create a profile 2002 and provide a wallet 2004 address to be able to offer the patent application for licensing in the digital marketplace. The wallet 2004 may enable users of the knowledge distribution system like owner ABC LLC transact with other users like potential licensees or crowdsourcers. The owner may also upload an image of the front page of the patent application including the patent number, title, abstract, and one or more figures. The digital marketplace may provide additional details about the NFT and the underlying IP on which the NFT is based. Such details may include a description 2006 of the IP, underlying blockchain 2008, contract address 2010, price history 2012 of the NFT, trading history 2014 of the NFT, smart contract details including full license 2040 terms of the NFT licensing contract, and the like. Additionally, any user of the digital marketplace may view the profile of the owner to view the trust score that may help a user in deciding if they wish to transact with the owner to buy or license the IP NFT. In embodiments, potential licensees may be provided with a ‘place bid’ button 2016, clicking on which they may place one or bids for an NFT. Once a potential licensee has provided a winning bid based on the terms of the auction, and transferred the proceeds, the smart contract may get triggered to transfer the ownership of the NFT to the winning bidder and record the transaction on the blockchain. The smart contract may thus provide liquidity and efficiency to an otherwise illiquid and opaque market of digital knowledge assets by enabling quick and transparent transactions on the blockchain.

In embodiments, the digital marketplace may provide a search interface 2018 to enable a user to search for one or more pieces of a digital knowledge (say tokenized as an NFT). A filter 2020 may provide users with a quick and easy way to navigate the digital marketplace and find products they are interested in. In embodiments, the filter 2020 may provide the user with a dropdown menu with various NFT categories available for licensing on the digital marketplace. For example, the users may be able to look for NFTs for various digital knowledge assets including intellectual property (e.g., patents, trade secrets, copyrights, trademarks, designs, know how, privacy rights, publicity rights, and others), instruction sets (e.g., 3D printing, semiconductor fabrication, process steps for crystal fabrication, polymer production, biological production chemical synthesis, food production, manufacturing, transportation) software codes (e.g., executable algorithmic logic such as computer programs, firmware programs, serverless code logic, AI logic and/or definitions, machine learning logic and/or definitions, cryptography logic), data sets and the like.

### Market Orchestration System Platforms

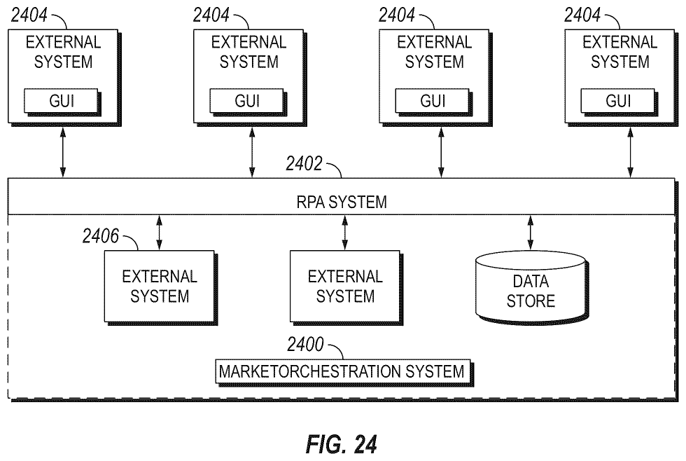

Referring to FIG. 24, the present disclosure relates to a market orchestration system platform 2400 that is configured to facilitate electronic marketplace transactions, referred to herein in the alternative as the “platform,” the “system” or the like, with such terms comprising various alternative embodiments involving various sets of components, modules, systems, sub-systems, processes, services, methods, and other elements described herein and in the documents incorporated herein by reference. According to embodiments herein, a marketplace may refer to an environment where assets may be listed and traded by buyers and sellers. Assets may refer to commodities, physical assets, digital assets, services, stocks, bonds, marketplace-traded funds (ETF), mutual funds, currencies, foreign exchange (FX), artwork and other works of authorship, alternative assets, recycled plastics, digital 3D designs, digital gaming assets, virtual goods, real estate, placement rights (such as for advertising), cryptocurrencies, metals and alloys, energy resources, derivatives (such as futures, forwards, options, puts, calls, and swaps), 3D printing capacity, digital twins, storage, intellectual property (e.g., trade secrets, patents, trademarks, designs, know how, privacy rights, publicity rights, and others), instruction sets, hybrid instruments, synthetic instruments, tranches of assets (including similar and mixed-asset tranches), streams of value (such as of interest), certificates of deposit (CDs), and the like, as well as portions of the above (such as divisible and undivided interests), hybrids of the above, and aggregates of the above (including tranches of securities, mutual funds, index funds, and others).

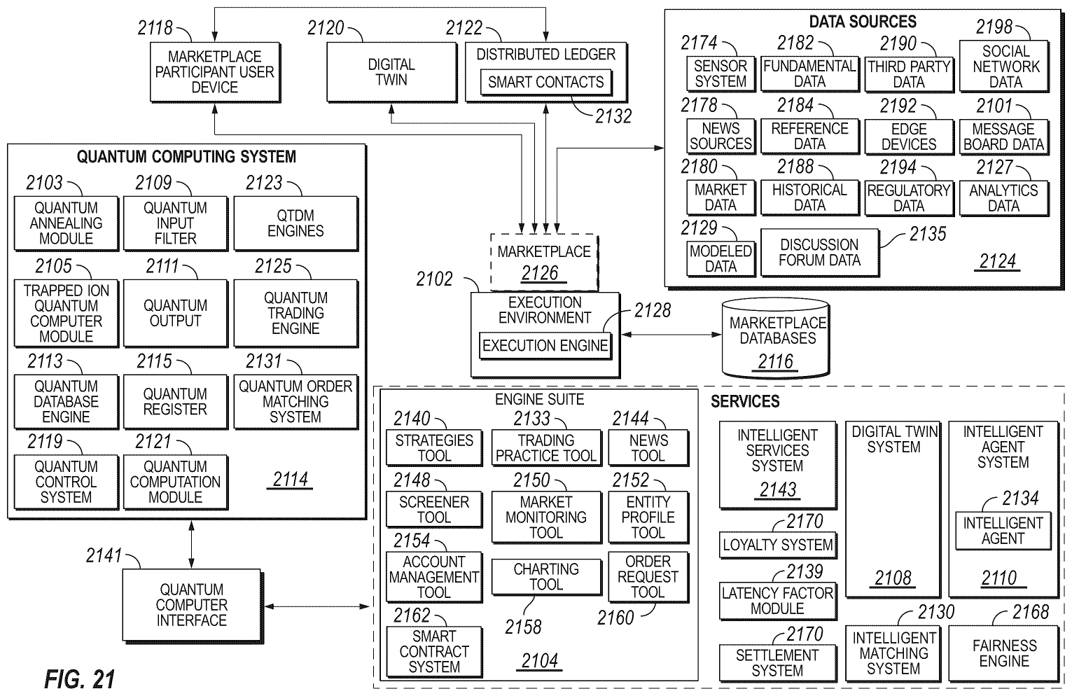

Referring to FIG. 21, the market orchestration system platform 2400 may include an exchange suite 2104, an intelligent services system 2143, a digital twin system 2108, an intelligent agent system 2110, and a quantum computing system 2114.

In embodiments, the platform 2400 includes an API system 2138 that facilitates the transfer of data between a set of external systems and the platform 2400. In some embodiments, the platform 2400 includes marketplace databases 2116 that store data relating to marketplaces, whereby the marketplace data is used by the exchange suite 2104, the intelligent services system 2143, the digital twin system 2108, the intelligent agent system 2110, and the quantum computing system 2114.

As used herein, quantum computing may refer to the use of quantum-mechanical phenomena (such as superposition and entanglement) to perform computation. Quantum computers may refer to computers that perform quantum computations. Quantum computers may be configured to solve certain computational problems, such as integer factorization (which underlies RSA encryption), with a fraction of the computational memory of traditional computers.

In some embodiments, the exchange suite 2104 provides a set of various marketplace tools that may be leveraged by marketplace participants (such as traders and brokers). The marketplace tools may include, but are not limited to, a strategies tool 2140, a trading practice tool 2133, a news tool 2144, a screener tool 2148, a market monitoring tool 2150, an entity profile tool 2152, an account management tool 2154, a charting tool 2158, an order request system 2160, and a smart contract system 2162. In embodiments, the strategies tool 2140 is configured to enable the creation and/or testing of pre-defined trade strategies. In embodiments, the pre-defined trade strategies may be configured for a particular asset type. In embodiments, the trading practice tool 2133 allows users to test and simulate strategies using an account funded with virtual money. In embodiments, the news tool 2144 may be configured to stream live media (e.g., CNBC), news feeds, and/or social media feeds (e.g., Twitter). In embodiments, the live media, news feed, and/or social media feed content may be related to the one or more asset(s) traded in the marketplace. In embodiments, the streamed live media content, news feed content, and/or social media feed content may be selected by an AI system, such as one that is trained based on selections by expert users and/or trained based on outcomes of usage, such as outcomes indicating successful trading activities and other outcomes noted throughout this disclosure. In embodiments, users may define streamed live media content, news feed content, and/or social media feed content to be displayed by the news tool 2144 via a graphical user interface. In embodiments, the screener tool 2148 allows users to filter assets by setting criteria via the graphical user interface. In embodiments, the market monitoring tool 2150 allows users to view marketplace-related data, graphics, heatmapping, watch lists, and the like. In embodiments, the entity profile tool 2152 allows users to view profiles of marketplace entities (e.g., company profiles, asset profiles, broker profiles, trader profiles, and the like) wherein the profiles contain information related to the respective marketplace entities. For example, the entity profile tool 2152 may allow a user to view an asset profile for an asset listed in the marketplace. In embodiments, the account management tool 2154 allows users to manage their accounts and to view account information (e.g., account balances, history, orders, and positions). In embodiments, the charting tool 2158 allows users to build charts related to assets to identify trends. For example, the charting tool may allow users to chart price over time for an asset to identify trends in price movement. The quantum computing interface 2141 enables the interface between the exchange suite 2104 and the quantum computing system 2114.

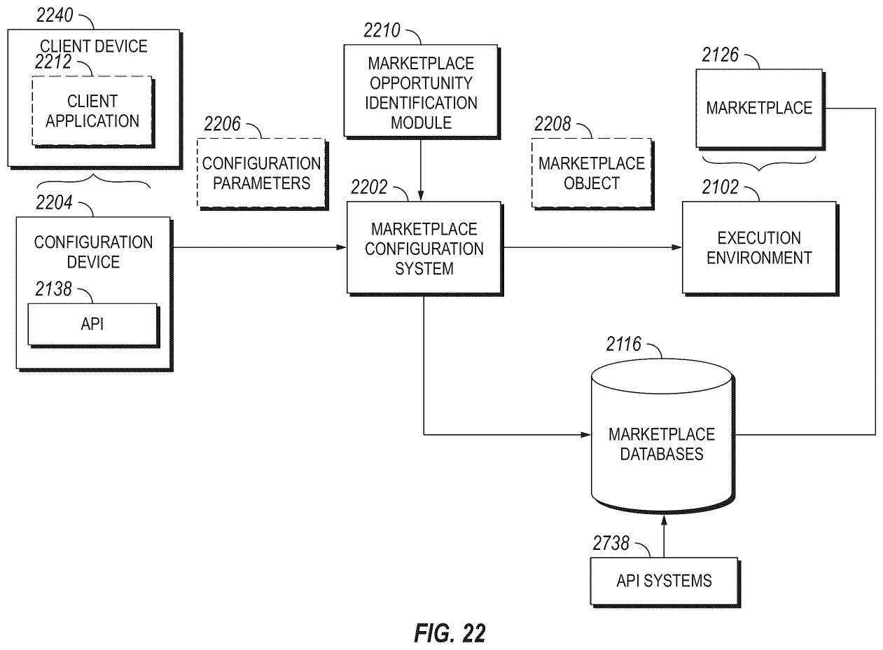

Referring to FIG. 22, the market orchestration system platform 2400 may include a marketplace configuration system 2202. In embodiments, the marketplace configuration system 2202 interfaces with a configuration device 2204. The configuration device 2204 may consist of any suitable computing device (or set of devices) that executes a client application 2212 that connects to the platform 2400 to provide configuration parameters 2206. Examples of configuration devices 2204 may include, but are not limited to, mobile devices, desktop computers, artificial intelligence-based trading systems, and third-party applications that interface to the marketplace API System 2138.

In embodiments, these third-party applications are thin layers that may consist of a mash-up of different APIs connecting various back end services. For example, the third-party applications may interface to the marketplace API and to a weather API, if weather is deemed relevant to trading a particular asset (e.g., in a market for 3D printed snow skis). In embodiments, these mashup environments connect to various systems without the different back end systems requiring knowledge of the mash-up environments. In some embodiments of the platform 2400, security is centrally managed or outsourced. For example, Google Authentication may be used via OAuth certificates providing for the mash-up to connect to multiple systems and not requiring multiple logins, such that it supports single sign-on.

In embodiments, the market orchestration system platform 2400 may be multi-threaded and provide for seamless real-time monitoring and execution of tasks. In some embodiments, the platform 2400 supports high-performance device implementation using compiled languages, including, but not limited to, SwiftUI™ and Flutter™

In embodiments, the market orchestration system platform 2400 may be configured to support automated testing. For example, building reliable handling of failures and errors may prevent an application crashing halfway through a trade.

In embodiments, internal device storage of the platform 2400 is based on encrypted data and encrypted use of memory to protect sensitive information, such as personal data, trade secrets and/or sensitive financial information, or the like, from discovery and hacking. In some embodiments, the platform 2400 is configured to enable obfuscation of trading network patterns to prevent third parties from monitoring network traffic to discover major trading events.

In embodiments, the platform 2400 is configured to support different types of traders, including retail traders, institutional traders, individual traders, secondary market traders, brokers, dealers, buyers, sellers, market makers, and others, as well as various other parties and counterparties to marketplace transactions, such as regulators, procurement officers, tax officials and other government personnel, reporters, analysts, bankers, custodial agents, trustees, proxyholders, service providers, ratings agencies, auditors, assessors, accountants, compliance parties, legal service providers, lenders, and many others. References to “traders” or “users” in examples and embodiments throughout this disclosure should be understood to encompass any of these, except where context indicates otherwise. The different types of traders and other parties will likely have different needs around performance specifications for the system, such as relating to latency of execution, latency of data availability, overall availability, quality-of-service, bandwidth, throughput, failover, failure avoidance, error correction, reconciliation, disaster recovery, and the like of the trading system, as well as varying needs for handling of automation capabilities (such as algorithmic execution) and varying needs for trade types and handling of asset classes (e.g., enabling exchange and/or arbitration opportunities between different market environments), and the like.

In embodiments, the platform 2400 is configured to support marketplace participant user devices 2118 in executing a set of atomic transactions in a sequence. In embodiments, these atomic transactions may require dependency (such as selling a first asset before buying a second asset). In some embodiments, the atomic transactions may be independent of sequence (such as selling an asset as fast as possible). In embodiments, orchestration may include generation and/or configuration of policies, rules, business logic, or the like that define sets of allowable transaction patterns by asset type, trade type, trader type, jurisdiction, or the like. In embodiments, these elements (collectively referred to for simplicity as “policies”) may be embodied in code elements that are attached to workloads and/or workflows for transaction execution, such that as transactions types are defined for particular asset classes, trade types, or the like, the policies are embedded into, integrated with, linked to, and/or wrapped around transaction objects, entities, states, and actions, such that each instance of a transaction carries with it the code necessary to recognize and apply policies, including context-sensitive policies, such as ones that are system-dependent, jurisdiction dependent, time-dependent, role-dependent, or the like.

In embodiments, the platform 2400 includes a message response system. The marketplace participant user device 2118 may consistently respond to real-time messages (such as notifications of events relating to market positions, such as trades, price changes, asset-class-related events, and many others). The response mechanism within the marketplace participant user device 2118 may be configured to respond to these messages with automated trading responses and/or with displayed notifications to the user of the device.

In embodiments, platform 2400 includes, integrates with, and/or links to an algorithm-based trading system having the ability to create, test, modify, and/or execute a set of automated algorithms. These automated algorithms may be controlled and managed by the marketplace participant user device 2118 and may be adjusted in real-time in response to changes in events or in response to user controls. In embodiments, the algorithm-based trading system may be constantly running in an extremely secure tier of an execution environment 2102 and may be run with or without the knowledge of the marketplace. In embodiments, the algorithm-based trading system may include algorithm control systems. If an algorithm is hidden in nature, the algorithm control systems may utilize obfuscation behaviors to constrain the ability of the execution environment 2102 to determine that artificial intelligence engines are undertaking trading activities.

In embodiments, the platform 2400 includes marketplace databases 2116. Marketplace databases 2116 may be ACID-compliant, and this ACID compliance may include building the data layer in the ACID-compliant database following ACID-compliant data management practices. ACID-compliant data management practices may include, but are not limited to, handling of duplication or aggregation of data as a part of a transaction or with a known latency against real-time, building a normalized data structure where data is not duplicated, rigorous time-stamping of all data to allow for seamless recovery of past states of the system, and transaction replication, which allows for real-time replication of fine grained data.

In embodiments, data may be configured differently for different types of marketplaces. The database schema abstraction may impact the implementation details for ACID compliance. For example, highly abstract storage may lead to a middle tier ACID implementation layer. In embodiments, the marketplace databases 2116 may include file systems, normalized schemas, denormalized schemas, replicated data, and/or star schemas. In embodiments, the marketplace databases 2116 may enable audit trails. In embodiments, the marketplace databases 2116 may enable blockchain sequencing for accounting resilience.

In some embodiments, the storage levels for the marketplace databases 2116 may include the storage of individual trades and/or the storage of aggregation of the trading information (current state only). In embodiments, historical trading information may be stored as the specific requests to allow for auditing and/or as more processed versions of the trading. For example, if trading is at an extremely high volume, the system may only be able to hold the current state; however, for audit purposes, a log of all historical requests is stored in a linear sequence, providing the ability to reconstruct a position in the market.

In embodiments, the marketplace configuration system 2202 provides an interface (e.g., a graphical user interface (GUI)) by which a user (e.g., a marketplace host) may configure and/or launch a marketplace. While described as a marketplace host, the configuration of the marketplace may be performed by other users, including, but not limited to, brokers and traders (e.g., buyers and/or sellers). In embodiments, the configuration of the marketplace may be performed automatically, as described in greater detail throughout this disclosure.

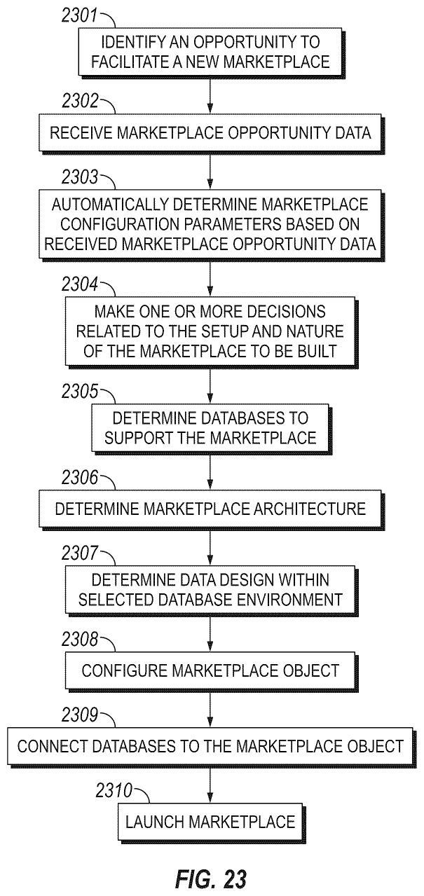

Referring to FIG. 23, a method is provided for launching a new marketplace according to some embodiments of the present invention. At 2301, a marketplace opportunity identification module 2210 identifies an opportunity to facilitate a new marketplace and/or identifies demand for a new marketplace. In embodiments, the marketplace opportunity identification module 2210 interfaces with third party electronic trading platforms (e.g., buying and selling platforms with shopfront-style trading), social networks, news sources, and the like and applies continuous automated monitoring and/or human-controlled monitoring of these sources for marketplace opportunities. For example, marketplace opportunity identification module 2210 may automatically detect a need for a marketplace for an asset class (e.g., a marketplace for digital twins) from an online source, such as a discussion board. In this example, marketplace opportunity identification module 2210 monitors demand and/or other factors indicating potential economic opportunity through the application of models, analytics, or the like, such as linear regression, and/or the application of artificial intelligence systems, such as neural networks or other AI systems described throughout this disclosure and the documents incorporated by reference herein. Continuing the present example, if the marketplace opportunity identification module 2210 finds that there is substantial demand for a marketplace for digital twins (such as a marketplace of digital twins of particular items), the marketplace opportunity identification module 2210 may make a decision to build a new marketplace to address such demand, enabling traders to buy and sell the digital twins. In examples, the marketplace opportunity identification module 2210 may make a decision to build a new marketplace for refurbished exercise equipment upon finding a substantial demand for such equipment via monitoring social networks. Continuing the example further, the refurbished exercise equipment may be delivered to the buyer, or the exercise equipment may be traded without the equipment being delivered to the buyer, thus creating liquidity in the market. In examples, marketplace opportunity identification module 2210 may automatically detect a need for airplane kit certification services from a trading platform chat discussion. Alternatively, a user (e.g., marketplace host) may identify a market opportunity and request to launch a new marketplace for one or more assets via the graphical user interface.

At 2302, the marketplace configuration system 2202 receives marketplace opportunity data (asset(s), asset type(s), asset data, asset demand data (demand quantities, demand locations, demand demographics, demand indicators), and the like) from the marketplace opportunity identification module 2210. In some embodiments, a user may define the assets and/or type(s) of assets that may be listed in the marketplace. In embodiments, the user may select different assets and/or asset types that will be supported for the marketplace by the platform 2400 via a GUI presented by the marketplace configuration system 2202. For example, the user may select different assets from a menu of assets and/or select different types of assets from a menu of asset types.

At 2303, the marketplace configuration system 2202 determines, optionally automatically, marketplace configuration parameters 2206 based on the received market opportunity data. In embodiments, the marketplace configuration system 2202 optionally leverages machine learning and/or artificial intelligence to automatically select marketplace configuration parameters 2206, such as to optimize the marketplace for efficiency, risk management, profitability, and/or other measures. In some embodiments, a user may enter marketplace configuration parameters via the graphical user interface. The marketplace configuration parameters 2206 may include, but are not limited to, assets, asset types, description of assets, method for verification of ownership, method for delivery of traded goods, estimated size of marketplace, methods for advertising the marketplace, methods for controlling the marketplace, regulatory constraints, data sources, insider trading detection techniques, liquidity requirements, access requirements (such as whether to implement dealer-to-dealer trading, dealer-to-customer trading, or customer-to-customer trading), anonymity (such as determining whether counterparty identities are disclosed), continuity of order handling (e.g., continuous or periodic order handling), interaction (e.g., bilateral or multilateral), price discovery, pricing drivers (e.g., order-driven pricing or quote-driven pricing), price formation (e.g., centralized price formation or fragmented price formation), custodial requirements, types of orders allowed (such as limit orders, stop orders, market orders, and off-market orders), supported market types (such as dealer markets, auction markets, absolute auction markets, minimum bid auction markets, reverse auction markets, sealed bid auction markets, Dutch auction markets, multi-step auction markets (e.g., two-step, three-step, n-step, etc.), forward markets, futures markets, secondary markets, derivatives markets, contingent markets, markets for aggregates (e.g., mutual funds), and the like), trading rules (e.g., tick size, trading halts, open/close hours, escrow requirements, liquidity requirements, geographic rules, jurisdictional rules, rules on publicity, insider trading prohibitions, conflict of interest rules, timing rules (e.g., involving spot-market trading, futures trading and the like) and many others), asset listing requirements (e.g., financial reporting requirements, auditing requirements, minimum capital requirements), deposit minimums, trading minimums, verification rules, commission rules, fee rules, marketplace lifetime rules (e.g., short-term marketplace with timing constraints vs. long-term marketplace), and transparency (e.g., the amount and extent of information disseminated). In some embodiments, marketplace configuration parameters 2206 may include allowing failed trades with no recourse.

In some embodiments, each type of asset has a predefined set of default configuration parameters. In some embodiments, the set of configuration parameters for each type of asset may be customized (e.g., by the marketplace host). In these embodiments, a user may define the marketplace configuration parameters that govern the marketplace for a type of asset.

In embodiments, a user, such as a buyer, seller, broker, agent, or the like, may define marketplace configuration parameters under which the user is willing to engage in trading activity and the marketplace opportunity identification module 2210 may use the defined parameters to identify opportunities to establish configurations that will encourage active trading among an aggregate set of parties that share configuration preferences. For example, a buyer may indicate a preference to trade in day-ahead futures of a defined type of token and be matched with sellers who hold such tokens are similarly interested in day-ahead trading.

At 2304, the marketplace configuration system 2202 makes or enables one or more decisions related to the setup and nature of the marketplace to be built. In this step, the marketplace configuration system 2202 may evaluate the received marketplace opportunity data and/or marketplace configuration parameters 2206 and prioritize the implementation of the marketplace based on a set of desired outcomes (such as overall profitability of the marketplace, efficiency of the marketplace, generation of threshold levels of overall participation and/or participation by parties of desired types, generation of threshold levels of trading activity, and the like). Configuration may be based on a model or plan of marketplace development, such as one that indicates and manages phases of marketplace development, such as market initiation (e.g., involving allocations of tokens, credits, trading rights, or the like according to desired rules or business logic), early stage marketplace development (such as involving offering incentives, subsidies, promotions or the like to facilitate development of trading activity to threshold levels), healthy marketplace operation (such as adjusting, optionally automatically, parameters of operation of the marketplace (such as smart contract terms, APIs, trading rules, or the like) upon receipt of indicators that the marketplace has reached threshold levels of trading and participation by desired numbers and types of counterparties and supporting users), and unhealthy operation (such as where one or more desired characteristics of market operation are outside desired ranges or thresholds, e.g., where trading is too thin, where gaming behavior is evident, where undue market power is evident (e.g., the market is cornered), where front-running is observed, or the like). In embodiments, artificial intelligence systems may be trained to recognize or understand the stage of a marketplace and to automatically adjust parameters of configurations of the marketplace based at least in part on the understood stage, including any of the configuration or other marketplace parameters noted throughout this disclosure. The artificial intelligence system may be trained by deep learning on outcomes, by use of a training set of data involving expert configuration by human operators, by combinations of the above, or by other techniques described herein or in the documents incorporated by reference, or other training techniques known to those of skill in the art.

In embodiments, the marketplace configuration system 2202 evaluates and experiments with new marketplaces, which may involve setting up test environments to determine if the marketplace is technologically or economically feasible and/or evaluating the marketplace with a test set of traders, with a test set of trading rules, with a test set of assets, with a test set of initiation parameters (such as incentives or promotions) or the like. In embodiments, digital twins may be generated by the digital twin system 2108 to perform simulations so that the viability of the suggested marketplace may be evaluated. Digital twins may include twins of goods (physical and digital) and other assets, twins of users, twins of environments and facilities, and other items. For example, a digital twin may track and represent conditions of physical items the ownership rights to which are to be traded in a marketplace, reflect impacts of environmental conditions (e.g., weather, climate, or other physical processes, and many others) on items, and the like, thereby allowing testers to observe impacts of physical changes in the marketplace (e.g., to test or simulate impacts of depreciation or degradation). Twins can similarly simulate marketplace activity, such as trading levels and patterns, price changes, and many others. In embodiments, the marketplace configuration system 2202 may determine that certain marketplace configuration parameters 2206 are unfavorable, and as a result, the marketplace configuration system 2202 may update the configuration parameters 2206 to improve and/or optimize the performance of the marketplace.

At 2305, the marketplace configuration system 2202 determines data sources to support the marketplace, including optionally configuring one or more databases. Configuration of a core database architecture may, in embodiments, facilitate various performance capabilities of the marketplace. Database types that may be implemented may include relational databases, SQL and NoSQL databases, highly real-time databases, graph databases, distributed databases, elastic databases, object-oriented databases, and the like, including various combinations of the above.

At 2306, the marketplace configuration system 2202 determines the architecture of the marketplace, which may include determining the tools and/or libraries used to support the marketplace. Decisions at this step may involve careful planning of the algorithms that may be used by the marketplace and around the key requirements for the system. Key architecture considerations may include logging requirements, audit requirements, acceptable latency, failover requirements, disaster recovery requirements, acceptable input/output volumes per period of time, volume of trades, requirements for complex transactions, and resolution of trades that take longer time periods.

At 2307, the marketplace configuration system 2202 determines the design of the data within the selected database environment using data modeling and data flow design tools. The data modeling processes may leverage data modeling tools and/or intelligent agents 2134 to lay out new schemas from scratch or to use existing template schemas. In embodiments, these processes may be fully automated using sophisticated automatic schema design tooling. Data modeling tools that may be implemented include, but are not limited to, ERWIN™, Visio™, and WhereScape RED™. Building on the architecture for the underlying database schema may be an iterative process involving block 2306 and block 2307 to determine the overall system architecture.

At 2308, marketplace configuration system 2202 configures a marketplace object 2208 in accordance with the determined architecture, configuration parameters 2206, and the like. The establishment of a new marketplace in this step may be either an entirely new kind of marketplace or an implementation of an existing marketplace with adjusted parameters. The marketplace configuration system 2202 reads the input parameters and loads them into its system. Key tasks in this step may include filling in default values, determining monitoring parameters (to determine when market is operating outside of its designed nature), management of failure and exceptions, and handling of hacking and security.

At 2309, the marketplace configuration system 2202 connects databases to the marketplace object 2208. In embodiments, the underlying database business rules are version-controlled and overlaid with version-controlled marketplace object 2208 that provides for the execution of trades. In embodiments, the marketplace object 2208 holds a set of metadata that defines the overall market operational parameters, the state held within this object can be held in version software (such as GIT or a version-controlled database). This version-controlled marketplace object 2208 may be used by the execution environment 2102 to operate the marketplace. In embodiments, the underlying database is designed to hold information regarding assets, transactions, and market positions held by buyers and sellers, as well as optionally holding various additional data and/or metadata about the above and other elements relevant to the marketplace, such as external factors that may impact buyers, sellers, assets, trading, or the like. In embodiments, connection information may include information about markets for derivative markets. For example, a marketplace for food delivery may include traders in derivative cash-settled marketplaces where the traders are betting on the future value of commodities in a monitored hot food delivery marketplace. Once the marketplace object 2208 is connected to the underlying database, the logic of the operating market may be tied directly to the data that is generated, which places a requirement that future releases of the marketplace object 2208 need to be able to seamlessly upgrade without breaking historic data collection rules. Future upgrades of the marketplace object 2208 may include upgrade logic that may include procedures that update the underlying database to make it compliant with the requirements of the future database.

In some embodiments, a user (e.g., a marketplace host) may connect one or more data sources 2124 to the market orchestration system platform 2400. Examples of data sources 2124 that may be connected to the platform 2400 may include, but are not limited to, the sensor system 2174 (e.g., a set of IIoT sensors), news sources 2178, the market data 2180 (such as level 1 and level 2 market data), the fundamental data 2182, reference data 2184, historical data 2188, third party data sources 2190 that store third party data, edge devices 2192, regulatory data 2194 (e.g., SEC filings), social network data 2198, and message board data 2101. Level 1 market data may refer to the real-time best bid-offer-volume data for a given asset while level 2 market data may refer to the real-time quotes for each market maker (e.g., individual market participant or member firm of a marketplace). Fundamental data may refer to data relating to a marketplace asset's underlying value and potential for future growth (e.g., revenue, earnings, and cash flow for a yield-producing asset, appraised or assessed value, or the like). Reference data may refer to marketplace entity identifiers used to complete and settle financial transactions. The data sources 2124 may include additional or alternative data sources without departing from the scope of the disclosure. Once the user has defined the configuration of a marketplace, wherein the configuration includes the selected asset types and trading rules, the user may then define the data sources 2124 that are connected to the platform 2400. In some embodiments, data from one or more of the data sources may be fused and/or analyzed before being fed into the platform 2400.

At 2310, the marketplace configuration system 2202 launches the marketplace. In embodiments, the marketplace configuration system 2202 may leverage cluster management tools (such as Trinity X™) to change the run-time parameters and operational nature of instances, allowing for the continuous operation in the face of workload demands. In embodiments, the marketplace configuration system 2202 may leverage high performance computing (HPC) clustering. In embodiments, clusters may be dynamically changeable based on the requirements of specific marketplaces or system workloads. In embodiments, the marketplace configuration system 2202 may allow for some marketplaces to be shut down in response to workloads (including excessive or inadequate demand) or in response to other factors, such as improper trading patterns (e.g., triggering of a market crash or bubble by unconstrained algorithmic trading systems), exogenous events (e.g., changes in other markets, natural disasters, civil unrest, or the like), etc. In some embodiments, the marketplace configuration system 2202 may allow for service-level agreements (SLAs) to be changed in response to demand and other factors. In embodiments, the marketplace configuration system 2202 may limit users on the system or change entry requirements for traders in an environment.

In embodiments, the marketplace configuration system 2202 enables a user (e.g., a marketplace host) to define the users that may access and/or may not access the marketplace. For example, the user may define a blacklist of users that may not access the marketplace and/or define a whitelist of users that may access the marketplace. As examples, a whitelist may include members of a trade organization, a set of members of an industry consortium, a set of members of a treaty, members of a corporate group, members of a list of permitted parties (e.g., parties on a government contracting schedule or the like), a set of parties to an agreement, or others. In embodiments, the marketplace configuration system 2202 enables a marketplace host to invite other users to trade in the marketplace. In embodiments, the platform 2400 may be configured to enable the creation of trader accounts for buyers and sellers. In embodiments, the platform 2400 may be configured to automatically generate a trader profile associated with each created account.

In embodiments, the platform 2400 may include serverless environments. In these serverless environments, the application software may run directly on “bare metal” computational infrastructure or in computational systems optimized for execution. The serverless environments may include a set of cloud environments where the cloud provider is completely responsible for service level, such as latency of response, overall memory availability, backup, disaster recovery, load balancing, and the like. In embodiments, the cloud environments may employ elastic load balancing, including application load balancing, network load balancing (including path-sensitive or route-sensitive load balancing), and the like.

In embodiments, the platform 2400 may allow users to add assets such that the assets are listed in the marketplace. In embodiments, the platform 2400 may allow users to remove assets from the marketplace such that the assets are no longer listed in the marketplace. In embodiments, the platform 2400 may be configured to automatically generate a profile associated with each asset. In embodiments, adding an asset may include digitizing an asset. Digitizing an asset may be performed by capture in digital media (such as scanning, photography, video, audio recording, or the like), by generation of digital content (such as entering descriptive information into an interface), or the like. Digitizing may include populating a digital object for the asset that corresponds to the class of the asset, where the object reflects parameters and attributes of the asset class and/or a data schema that is appropriate for the asset and for the marketplace. Attributes may include digital representations of analog data (such as transformed, compressed, or similar data), physical data, logical data, outputs of natural language processing, metadata elements, and the like. Digitizing may include automated extraction, transformation and loading of data, including steps of normalization, deduplication, clustering, scaling, cleansing, filtering, linking (such as linking to one or more identities), and the like. Digitizing may be performed by artificial intelligence, such as by robotic process automation, where the artificial intelligence system is trained to digitize an asset according to a data schema, object class, or the like based on a training set of data wherein one or more experts has digitized assets of the same or similar type. In embodiments, adding an asset may include uploading metadata related to the asset. In embodiments, adding an asset may include uploading one or more photos, videos, virtual reality experiences, documentation, digital twins, and the like.

In embodiments, a user may create an order request for an offer to buy or sell one or more assets. In embodiments, a user may select an option to create a new order request. In some of these embodiments, the user may be presented a GUI to provide one or more parameter values. For instance, the GUI may include fields for the user to identify one or more assets and define a requested action (e.g., buy or sell), quantity of asset(s), order type (e.g., limit order), price, time-in-force, special instructions, advanced order entry, and the like. In embodiments, the platform 2400 may be configured to enable the cancellation of orders. In some of these embodiments, the order cancellation may be triggered upon the detection of an event, such as by one or more monitoring and/or detection systems described herein or in the documents incorporated herein by reference. Events that result in cancellation may include price shifts in the marketplace or another marketplace, changes in eligibility or other statuses of a party, changes in state of an asset, changes in regulatory or policy factors, cancellation actions by a party, and others.

In some implementations, the platform 2400 may include an execution engine 2128. In embodiments, the execution engine 2128 may be configured to receive an order request from a party to execute a transaction for one or more assets listed in a marketplace. In embodiments, the execution engine 2128 may be configured to selectively execute a transaction based on the order request. For example, the execution engine 2128 may receive an order request, which may include, but is not limited to, requested action (e.g., buy or sell), quantity, asset(s) (e.g., stock symbol), order type (e.g., limit order), price, and time-in-force. The execution engine 2128 may, upon determining that the requested order is permissible (e.g., the assets are not illegal and there is no detected fraudulent activity), feed this information into an intelligent matching system 2130 that matches the order to one or more other orders (e.g., matching a buy order with a corresponding sell order for the same asset type where the respective prices are compatible). In embodiments, the execution engine 2128 may receive matched orders from intelligent matching system 2130 and execute the matched orders. In embodiments, the execution engine 2128 may generate a trade confirmation and send the trade confirmation to the one or more traders associated with an executed transaction.

Smart contracts are executable computer programs that operate upon relevant inputs from data sources and apply logic that embodies a set of applicable contract terms and conditions to produce outputs. In embodiments, smart contracts may be compiled into a data block in a distributed ledger or other data repository and may be configured to be deployed on computational infrastructure with appropriate provisioning of computational resources, definition of interfaces (e.g., APIs), and security framework (e.g., setting permissions for identities, roles, and the like). Once deployed to a distributed ledger or other secure computational platform, the smart contract may be accessed by data connection by various computational systems, such as to accept inputs and to provide outputs. In embodiments, a smart contract is deployed on a ledger that provides cryptographic security, such as involving a blockchain, such that the smart contract may be executed with confidence that it has not been modified by a malicious actor. While referred to as “smart contracts” because they may represent and implement agreements between various parties, such as regarding the transfer of cryptocurrency, the purchase and sale of goods, and transactions involving other types of assets, a smart contract does not strictly have to represent an explicit contractual arrangement; for example, a smart contract may implement business logic upon inputs to provide outputs within a workflow or business process.

In embodiments, a smart contract may be written in program code using a scripting language such as JavaScript, Solidity, Python, or other scripting languages, or an object coding language, such as Java, or a machine coding language such as C or C++. When a smart contract is deployed, such as into a distributed ledger or other computational systems, the program code may be processed into a block by a participant and written to the distributed ledger or other computational systems in the same manner any other data block is written to the distributed ledger or system (for example, in exchange for a fee paid to the node participant who compiles the contract/program). In embodiments, the process of deploying the smart contract may include compiling the program code into bytecode, object code, binary code, or some other executable form. When the smart contract is successfully deployed, the smart contract/data block containing the smart contract may be assigned an address, which may subsequently be used to access the smart contract and execute the functionality provided therein. In embodiments, a smart contract may include a connection to or provision of an Application Programming Interface (API), a connection to or provision of an Application Binary Interface (ABI), which is analogous to an API, or other interfaces (such as a bridge, gateway, connector, portal, or other data integration interface), such that the smart contract may interface with external software modules and systems. In this way, the smart contract may interact with various software modules (e.g., a wallet application and/or other smart contracts), data sources (such as data feeds, event streams, logs, search engines, and many others), and/or a user of the smart contract. In embodiments, a smart contract may have API, ABI, or other connection interface information associated therewith that defines a manner by which a user leverages the interface so that the user can interact with the various functions of the smart contract. In embodiments, the connection interface information describes the various functions and methods provided as part of the smart contract so that they can be accessed by the user or the user's software.

Once a smart contract has been deployed, the smart contract may then be used by access to the address of the smart contract according to defined permissions, which may include open access and/or private access. In embodiments, executing the contract, or a portion of it, does not necessarily incur fees unless required as part of a step in the contract (such as fees required to update a distributed ledger upon which the contract is deployed). In embodiments, many different users may utilize the contract/program simultaneously to govern their own specific agreements or transactions.

In some embodiments, the smart contract may be invoked by conditional logic (e.g., as defined in the program code of the smart contract, of another smart contract, or being executed by a software system). For example, a smart contract may be invoked upon the occurrence of external or internal events. An external event may be an event that occurs independent of the smart contract and the parties associated therewith, while an internal event is an event that occurs with respect to the smart contract and/or the parties associated therewith. In embodiments, a smart contract includes conditional logic that responds to a set of triggers and executes a set of steps (e.g., a set of smart contract actions) that are performed by the smart contract in furtherance of the smart contract. These actions may include recording documentation of events, transferring funds or assets, filing documents with governmental, regulatory, or corporate entities, initiating a workflow (e.g., maintenance workflows, refund workflows, purchasing workflows, and/or the like), and/or other suitable actions. In embodiments, a smart contract may be configured to receive data that is indicative of events, for example, via an API, ABI, or other connection interfaces of the smart contract. In embodiments, the smart contract may include a listening thread that listens for specific types of data. In embodiments, the smart contract may employ an active thread, such as a search or query of applicable logs or other data sources, to search for relevant events or triggers. When the data is received and/or retrieved, the smart contract may process the data and operate on the data using the conditional logic defined in the smart contract. For example, in response to the conditional logic detecting the occurrence of an event or other trigger, the smart contract may execute the smart contract action defined therein. In embodiments, the parties may agree to a manner by which triggers are verified, such as which data sources may be leveraged to verify events.

In embodiments, a smart contract 2132 may refer to software (e.g., a set of computer-executable instructions) executed by one or more computing devices that performs one or more predefined actions upon verification of one or more triggering conditions/events, where the actions and triggering conditions/events embody the terms and conditions of an agreement among counterparties that is reflected in the structure of the smart contract. For example, a smart contract may be configured to monitor the price of a barrel of oil and to transfer the contract rights to a set quantity of oil from a seller to a buyer when the price of a barrel of oil falls below a threshold, such that the transfer of contract rights from the seller to the buyer is the predefined action of the smart contract and the price of a barrel of oil falling below the threshold is the predefined condition. In embodiments, smart contracts may be stored on a distributed ledger 2122 (e.g., a blockchain) and may be executed by the nodes that store the distributed ledger 2122. Additionally or alternatively, the platform 2400 may execute smart contracts generated by or associated with the platform 2400. In some embodiments, the platform 2400 and/or one or more of ledger nodes that host the smart contract may provide an execution environment on which the smart contract 2132 is executed. In embodiments, the smart contract may be defined in accordance with one or more computing protocols (e.g., the Ethereum protocol). In some embodiments, the smart contract 2132 may be contained and/or executed in a virtual machine or a container (e.g., a Docker container).

In embodiments, a smart contract may operate on a set of data storage and computational resources, which may be optionally shared with other services, components, systems, modules, sub-systems and/or applications of the platform 2400, such as where the smart contract system includes or is composed of a set of microservices that are part of a set of microservices in the architecture for the platform 2400. Storage, computation, and workflow execution may be performed, for example, on a set of blockchains, such as on a set of blockchain-based distributed ledgers; on a set of application programming interfaces, such as APIs for input connections to a smart contract and output connections from the smart contract to various other systems, services, components, modules, sub-systems, applications, or the like; on a set of dedicated hardware devices (including hardware wallets, hardware storage devices of various formats (hard disks, tape, cloud-based hardware, data center hardware, servers, and many others); in a set of wallets; in a set of accounting systems; in a container; in set of virtual machines; embedded within an API to a marketplace; on a public cloud; on a public/private cloud (such as where elements are subject to varying permissions/authorization); on an intelligent switching device (such as an edge computational device or a network device that is provisioned/assigned to an exchange or marketplace); on and/or integrated with a physical asset to which the smart contract relates, such as in the premises of the asset in a local area network and/or physically located on the asset (such as on an asset tag or integrated into a native storage system of an information technology system of the asset, such as an on-board diagnostic system of a machine or random access memory of a consumer device); integrated into a digital twin of an asset to which the smart contract relates (such as any of the types of twin described herein); in a software system (such as an ERP system, a CRM system, an accounting system or the like); embedded in a collaboration system (such as a shared document environment (e.g., a Dropbox™, Google™ doc, sheet or slide presentation, or the like)); embedded in a communication system storage element (such as a video-conferencing system storage element); embedded in storage for a marketplace execution engine (such as a payments engine, a fulfillment engine, or the like); and/or combinations of the foregoing, and various others.

In embodiments, a smart contract 2132 may include executable logic, data, and/or information related to facilitating a marketplace transaction, including one or more triggers and one or more smart contract actions to be executed in response to indication or verification of one or more of the triggering conditions or events. In embodiments, the triggers (e.g., triggering events or conditions) may define conditions that may be satisfied by performance of activities by one or more parties (such as the sellers, buyers, agents, third parties, etc.) and/or occurrences of events outside the performance of parties (e.g., a value of an asset or set of assets exceeds or falls below a threshold, the occurrence of a natural disaster within a geographic region, the allowance of a particular intellectual property right by a particular jurisdiction, the degradation of the condition of an asset, the depreciation of the value of an asset, a regulatory change, or the like). Examples of the triggering events or conditions include payment of a defined amount of currency by one party (e.g., the buyer), verification that a party to a marketplace transaction is within a defined geographic area (e.g., a country, city, state, or the like), verification that an asset has been certified by a third-party, verification of an occurrence of a predefined market condition, or the like. Examples of smart contract actions may include initiating a transfer of an asset from a seller to a buyer, recording a transfer of ownership of an asset from the seller to the buyer on a distributed ledger, adjusting one or more terms (e.g., price, interest rates, allocation of responsibility or other suitable terms) in response to determining that a party to the transaction is located within or outside of a predefined area, or the like.

In some embodiments, the smart contracts may be generated by expert users (e.g., smart contract developers) that are associated with customers or the platform 2400. Additionally or alternatively, the platform 2400 may provide a graphical user interface that allows a user to parameterize a smart contract based on a smart contract template. In some of these embodiments, the platform 2400 may include a set of predefined smart contract templates that are used for different types of transactions and/or different types of assets. Each smart contract template may include predefined code that may include parametrizable instructions, such that a user may provide one or more values to parametrize the parameterizable instructions. In these embodiments, a smart contract developer may define the smart contract templates, whereby the smart contract templates include parameterizable fields.

Additionally or alternatively, the platform 2400 may provide a robotic process automation or other artificial intelligence systems that may generate a smart contract and/or a smart contract template, and/or may parameterize a smart contract that is characterized by a template, based on a model, a rule set, and/or a training set of data created by one or more expert users, or combinations thereof. For example, a model may be provided to an artificial intelligence system for generating a smart contract that embodies an option transaction, where the artificial intelligence system is trained to generate the smart option contract based on a training set of data whereby expert users generate option contracts for options to purchase an asset class, including training data that indicates selection by the expert users of the duration of the options, the pricing of the option itself, and the pricing of the asset upon triggering of the option.

In some embodiments, the smart contract template may be associated with a type of marketplace, such that the template may be used to generate smart contracts suitable for the types of assets and the types of transactions that occur within the particular marketplace. In some cases, this may include a smart contract template for each transaction type for the marketplace, for each asset type and/or for each combination of asset and transaction type. For example, a template may relate to a smart contract for a purchase and sale contract for defined quantities of a commodity in a commodities exchange, or it may relate to a firm price offer for a defined product, deliverable or service in an outsourcing marketplace or a reverse auction marketplace. In some embodiments, the set of smart contract templates that may be parameterized for a particular marketplace may be limited by the type of the marketplace. For instance, in supporting generation of smart contracts for trading financial instruments, the set of parameterizable smart contract templates may be limited to smart contracts that govern the selling, buying, trading, and/or optioning financial instruments. Similarly, in supporting generation of smart contracts governing the trading of real property rights, the set of parameterizable smart contracts may be limited to smart contract templates that govern the selling, leasing, buying, trading, or otherwise transacting with respect to real estate. In this example, smart contract templates governing real estate transactions may be parameterized with an address of the real estate, a price associated with the transaction, requirements (e.g., cash only, proof of financing, citizenship/legal status in the jurisdiction of the real estate, or the like), parties associated with the transaction (e.g., property owner, seller agent, and/or the like), legal terms and conditions (e.g., liens, encumbrances, rights of way, property boundaries, and the like), or other suitable parameters.

In example implementations of a warranty smart contract configured to manage a warranty for a product, the warranty smart contract may be configured to be invoked in response to the purchase of a product. In this example, a customer registering the product on the seller and/or producer's website, the product (e.g., a smart product) being turned on and connecting to a network, the sale of the product itself (e.g., via a marketplace), and/or other suitable events may trigger the invocation of the smart contract. In response, the smart contract may execute at one or more nodes of the distributed ledger and may listen for or actively retrieve specific data. For example, if the product is a smart product, the product may report usage data (e.g., such as each time the product is used, each time the product is turned on, and the like), error data (e.g., each time the product encounters an error condition), misuse data (e.g., when an accelerometer or other motion data collected by the device indicates the product was misused), or other suitable data. Upon detection of a trigger, the smart contract may automatically calculate an applicable warranty period, such as ninety days from product activation, thirty days from purchase, or the like. In embodiments, a smart contract may be configured to initiate issuance of a refund or replacement product in response to determining that the product is in an error state that cannot be resolved. In examples, the warranty smart contract may be configured to void the warranty if the smart contract receives misuse data that indicates that the product is damaged as a result of misuse of the product.

As described elsewhere herein, smart transactions may include automated smart contract negotiation/review, such as for establishing, among other things, contract enforceability. Automated smart contract negotiation/review may include configuring logic and/or artificial-based intelligence for ensuring that contract terms are at least enforceable and that terms in the contract can be enforced. As a smart contract is being constructed/negotiated and/or as part of contract review, computing logic, interfaces (computer-based and real world), and validation functions could be instantiated and performed based on terms of the contract, preferences of the participants, agreements of the participants, market factors, risk, existing contracts, and the like. A smart contract could consider events that trigger a condition of a contract and ensure that they can be detected and validated, optionally on an ongoing basis during the life of the contract. A smart contract generation process could consider the conditions on which a contact is based (e.g., terms) and ensure that they are detectable. A smart contract could consider contract actions required and ensure/validate that they can be successfully taken. A smart contract could be configured to be aware of the “type” of contract, such as a domain in which the contract is operative and adapt itself (e.g., ensuring terms are compliant within a regulated industry). A smart contract could consider risk when instantiating/validating interfaces. This may be beneficial to contract stability and may ensure that a high-risk contract participant might require more onerous initial (and possibly ongoing) validation (and consequently stricter terms) as compared to a low-risk participant. Further, a smart contract could use risk to determine/adjust aspects of a contract (or actions based on terms in the contract), such as frequency of checking an account balance or the like.

In embodiments, a smart contract might be interactive with a negotiating participant. It may present impact scenarios for a proposed contract term to a participant and offer alternatives, such as suggesting conditional escrow in lieu of direct payments, etc.

A basic smart contract negotiation/review/enforceability example of ensuring enforceability for a royalty term (e.g., pay X to A when Y is sold by B) might involve several actions that may be performed in one or more sequences, such as the following exemplary sequence: (i) identifying a payment account for A into which the royalty is to be paid and ensuring that a deposit into that account can be verified; (ii) verifying an interface to a sales/AR system of that tracks when Y is sold; (iii) verifying that a sale of Y by B can be detected; (iv) detecting an interface to a financial account of B that is credited when Y is sold, etc. Ensuring enforcement might include further establishing conditional rights (and the real-world mechanisms) to perform a financial transaction from the sales account of B to the royalty payment account of A. A smart contract could instead enforce sales proceeds of a sale of Y to pass through an interim account where the royalty could be withdrawn (under proper contract terms) so that the royalty recipient A is not dependent on the Y seller B to voluntarily make the royalty payment.

In examples of a smart contract implementation, a smart contract may be configured to facilitate distribution of a settlor's estate upon the settlor's death. Such an estate smart contract may take into account participants of an estate including inheritors of the estate, such as descendants of the settlor, entities defined in the estate or related contracts (e.g., a settlor's will and the like), administrators of the estate, such as a Trustee, Independent Trustees, personal representatives, and the like. Participants may be individually identified and/or defined, through use of terms such as “descendant.” Estate administrators may be defined individually (e.g., a person and/or an entity such as a law firm and the like). Additionally, estate administrators may further be defined through estate rules for establishing and maintaining such administrators.

Relationships for the purpose of administration and/or distribution of an estate between and among the participants may be called out in or in association with an estate smart contract. An example of how an estate smart contract may be configured to address relationships among participants may include automatic generation, delivery, and verification of attestation agreements for each participant. An estate smart contract may rely on the terms of an estate that require, for example, that an Independent Trustee be unaffiliated with other participants and under no obligation of and receive no benefit from the estate to generate an electronic attestation document and work cooperatively with a digital signature system (e.g., such as a system by which real estate transactions and other contracts are executed) for verification thereof.

An estate smart contract may be configured to determine asset control terms by which assets of the estate are to be administered and/or distributed. The asset control terms of or for an estate smart contract may cover different phases of an estate (e.g., a first estate phase while the settlor is alive, a second estate phase after the settlor's death, a third phase based on an age of an inheritor, and the like) and therefore may provide for different control of estate assets based on the current phase of the estate. As an example of estate smart contract asset control, during a lifetime of a settlor, a financial account may be placed under the settlor's control. Upon verification of the settlor's death, which may be automated in a range of ways, control of the financial account may automatically be changed to the designated Trustee of the settlor's estate. This may involve verification of the settlor's death certificate (automated or otherwise) and presentation thereof to an account control designation function of the financial account along with the necessary authorization by the Trustee to be designated as the owner of the financial account. An estate smart contract may be configured with functions and/or interfaces through which necessary information, such as electronic delivery of a verified death certificate, and/or legally identifying information for the trustee may be accessed and used for financial control change purposes.

Assets of the estate that may be administered and/or distributed through use of an estate smart contract may include physical assets (e.g., objects, real estate, and the like), financial assets (e.g., bank accounts, investment accounts, retirement accounts, individual financial instruments, cash, and the like), and financial obligations (e.g., debts, business obligations of the settlor, estate taxes, estate administrative fees, legal fees, and the like). An estate smart contract may facilitate distribution of a family heirloom (e.g., an autographed baseball) to an inheritor (that may be defined in a linked smart will contract) by automatically notifying the inheritor of the object, processing instructions from the inheritor regarding the disposition of the object, and coordinating the inheritor's instructions with a physical asset disposition service.

An estate smart contract may be configured to be linked with other contracts (smart or otherwise) that may have dependent terms, such as settlor's will, an inheritor's will, and the like. Operation of an estate smart contract, such as for administration and/or distribution of assets of an estate upon a settlor's death, may therefore be configured to automatically identify and enable dependence upon terms of such a linked contract. In examples of smart contract linking for facilitating distribution of estate assets a settlor's will, an estate smart contract may define one or more assets to be placed into the estate upon the settlor's death. An estate smart contract may facilitate renaming the asset, such as a vacation home, into the name of the estate by providing, electronically and/or as physical documents, the authorization needed by a government agency, such as county records department to make the change in ownership name. Such a smart contract action may instead occur based on other terms defined in the estate, such as in response to an estimated value of the vacation home exceeding a resale threshold.

An estate smart contract may be configured to facilitate estate administration and/or asset distribution based on terms of an estate. An exemplary term may involve age limits for estate asset distribution, such as a minimum age after which a portion of an estate designated in an estate smart contract for an inheritor may be distributed free of trust to the inheritor. Upon detection or notification of the inheritor reaching the minimum distribution age (e.g., based on verifying a birth certificate of the inheritor and setting a date for distribution based thereon), the smart estate contract may automatically notify an estate trustee and the inheritor of the assets and may further provide the inheritor access (e.g., email a username and password of a brokerage account) to those assets designated for age-based distribution. Another exemplary estate term may relate to generations of descendants so that, for example, distribution of estate assets to a descendant of an inheritor may be free of trust. Another exemplary estate term that may be configured into an estate smart contract may relate to a requirement for the presence of one or more trustees at one or more phases of the estate. In a basic example of a smart contract facilitating estate distribution with trustee management, an estate smart contract may provide a portal through which a trustee may be designated and/or through which a designated trustee may decline designation. Such a portal may be linked to a trustee control facility of the estate smart contract that may automatically designate an alternate trustee (if an alternate trustee has been identified or is identifiable) and/or notify a third party, such as a personal representative of the settlor, a descendant of the settlor, and the like of a need to designate a trustee.

An estate smart contract may be configured with tax optimizing logic that may, based on value of assets of an estate, reconfigure an estate to gain tax benefits for one or more inheritors, such as by splitting an estate into two or more related estates with suitable taxable designations.

In examples of a smart contract implementation, a smart contract may be configured to close a contract or a portion thereof. Contract terms may include severability that facilitates closing portions of a contract, such as one or more terms of a contract, without causing an entire contract to be closed. Contract terms may include conditions under which a contract may be closed. Closing of contracts, or portions thereof may include one or more parties to the contract exercising a right, optionally a conditional right, to close. Closing contracts, or portions thereof may automatically include closure, such as when a term of a contract is satisfied (e.g., when a delivery is confirmed, when a deliverable is not made timely, and the like).

Smart contracts may be configured to facilitate closing a contract or portion thereof by evaluating, from time to time, compliance with and/or satisfaction of terms and conditions of the terms of a contract. A smart contract that is, for example, executable on one or more processors may be configured with a contract term evaluation facility, such as a set of logic executable on the one or more processors that receives as inputs data representative of conditions of the contract that facilitate determining adherence to a contract term, such as a contract term start date, end date, start condition, end condition, and/or a derived value based on measurable elements of the contract (e.g., a minimum level of inventory at a local distribution depot), and the like. Such a contract term evaluation facility may be controlled by other terms in a contract, and therefore may process data representative of another contract term, such as a time period over which the inventory level must be replenished up to the minimum level. In this example, the contract term evaluation facility may generate a term evaluation result that may impact a state of the contract from “active” to “pending closing.” The smart contract may further include contract state processing logic that may, based on conditions activated when a portion of the contract is pending closing, perform actions to configure transactions and the like that can automatically be executed to close the contract (or the relevant portion thereof) if the conditions required to change the contract state back to “active” are not met, such as if inventory records remain below a minimum value beyond the replenishment period. An example of transactions that may be loaded for automatic execution by the smart contract may include transfer of funds from an escrow account to a private account of a participant defined in the contract for receiving the escrow balance upon closing of at least the relevant portion of the contract. Another example transaction may include issuance of an amended and restated contract with the closed portion removed. In embodiments, closing a portion of a contract may impact terms in other portions, such as for commercial contracts, payment schedules. Therefore, a smart contract may automatically adjust these other terms in the amended and restated contract.

A smart contract may close an entire contract by taking actions defined in contract closing terms, such as automatically returning a deposit to a buyer, notifying at least the participants (and any other parties identified in the closing terms) of the contract closure, renegotiating terms of the contract, signaling to a request for proposal facility to reactivate requesting proposals (or activating a backup contract with a third party) for work defined in the contract that was not delivered, and the like.

In examples of a smart contract implementation, a smart contract may be configured to trigger a remediation event. Parties may enter into an agreement that may be memorialized by a contract, optionally a smart contract that may define events that contribute to compliance with contract terms as well as events that may be triggered based on terms in the agreement, such as contract terms. One such event that may be triggered based on terms in an agreement is a remediation event. In embodiments, a remediation event may direct mediation actions to make one of the parties of the agreement whole when another party of the agreement fails to comply with terms of the agreement. In embodiments, a remediation event may cause remediation actions when conditions that are outside of control of the parties to the agreement occur, such as a natural disaster, pandemic, and the like. A smart contract may be configured to understand conditions that may require triggering a remediation event. In embodiments, a smart contract operable on one or more processors may be configured with machine learning logic that may, over time, identify patterns of one or more parties to the agreement regarding actions/conditions that the smart contract is monitoring to ensure compliance. The smart contract may determine that a party consistently provides a deliverable identified in the contract at the end of an extended delivery grace period while requiring early payment. In this example, the smart contract may trigger a remediation event that may initiate renegotiation of the terms of the agreement. Another remediation action that the smart contract may trigger is to reprioritize compliance with terms of the agreement so that lack of compliance with other terms that had smaller impact on the agreement may be increased in importance, such as to be flagged to the affected party and/or to trigger other actions that would, under nominal contract execution conditions, not be triggered.

In examples of a smart contract implementation, a smart contract may be configured to deliver crypto keys to a digital product (private key event). Conducting secure digital transactions over a network may require use of crypto keys, such as public and private crypto keys to ensure, among other things, that participants of such a transaction can be digitally verified. Smart contracts may be utilized to facilitate conducting secure digital transactions over a network by, among other things delivering crypto keys. A smart contract may further be utilized to facilitate use of digital products, such as by delivering crypto keys to the digital product. In a smart contract example, two parties may desire to enter into an agreement for use of a digital product to conduct transactions on their behalf, such as a digital product that conducts secure transactions among parties for payments and the like. This agreement may be constructed as a smart contract that may be provided with public crypto keys for the participants so that transactions defined by the agreement can be conducted electronically, such as through the use of a Blockchain and the like. Such a smart contract may be configured with not only the public crypto keys of the participants, but other keys that are required to conduct the transaction, such as crypto keys for digital products (e.g., a mobile transaction platform) to enable the digital product(s) to play a role in the execution of the agreement. A transaction conducted under such an agreement may involve the smart contract signaling to the digital product that participant A in the agreement wishes to perform a transaction with participant B of the agreement, such as sending digital currency to participant B. The smart contract may, optionally, validate the transaction is in compliance with the terms of the agreement (e.g., ensure that the payment to participant B meets a condition of the contract) and then forward a public encryption key for participant B (optionally along with transaction instructions) to the digital product. The smart contract may be configured with conditions, terms, and logic that is processed to ensure that the use of the digital product is also in compliance with the agreement (e.g., that the transaction amount does not exceed a maximum threshold for use of the digital product and the like).

In examples of a smart contract implementation, a smart contract may be configured to configure and execute auctions. In embodiments, rules of an auction, such as an established minimum bid, bid increments, financial or other qualifications of bidders, obligations of bidders when making a bid for an item, obligations of auction participants offering items at the auction, forms of payment, and the like may be configured as features of a smart auction contract. Bidders may be participants to the auction smart contract with a set of terms of the contract established and enforced for their participation, such as auction attendance, establishment and use of proxies, and the like. An auction smart contract may comprise a functional, computer executable contract that automates establishing and enforcing binding agreements among buyers, sellers, an auction service, third-parties, such as item transportation and warehousing providers and the like. An auction coordination service may configure an auction smart contract with pertinent information that facilitates operation of an auction from initial auction planning through to delivery of auctioned items, such as time, place, bidding process, requests for items for the auction, allocation and use of auction proceeds, terms for third-parties to participate in the auction, and the like. In embodiments, an item-specific smart contract may be configured for each item for auction with its own terms, such as minimum bid, acceptable form of payment, and the like. Each item-specific smart contract may be linked (e.g., logically, operationally, and the like) with one or more smart auction contracts, such as a master smart auction contract. An example of logical item-specific smart contract linking with a master smart auction contract may include sharing certain information, such as auction location, auction payment processor, item order of auction (e.g., which item is auctioned before and which item is auctioned after the item for which an item-specific smart auction contract is configured), and the like. In examples of a smart item-specific auction contract, terms such as minimum bid amount (bidding does not start until a participant makes an offer of at least the minimum bid amount), payment facilitator (vendor, such as a credit card transaction service, digital currency service, and the like), service fee recovery supplemental amount (e.g., in addition to the bid amount, an auction service fee, logistics vendor fee, charitable donation fee, and the like), distribution of proceeds based on a fixed amount per item and/or a percentage of auction price from a winning bid (e.g., 2% auction service fee, 5% or $25 logistics fee whichever is less, 3% charitable donation rider and the like) may be configured as logical terms that are enforced by execution of a smart auction contract.

In examples of a smart contract implementation, a smart contract may be configured to facilitate distribution of currency tokens and/or tokenized digital knowledge. Allocation and distribution of currency tokens, digital knowledge tokens, digital assets, and the like may be based on one or more terms of an agreement or a set of agreements that establish the who, what, why, and when of digital token distribution. A typical contract for controlling digital token distribution, such as currency tokens, digital knowledge token and the like, may be embodied as a smart contract configured to operate within the agreement terms. Elementary examples of capabilities of a smart contract configured for digital token distribution include automating reallocation of digital assets among participants of an agreement embodied as a digital contract based on terms of a contact, such as based on financial market movements, and the like. Terms of the agreement for conducting reallocation may be further dependent on use of a marketplace, such as a distributed financial transaction platform (e.g., a Blockchain-based transaction platform and the like.) A smart contract may be configured with interfaces and operational logic that identify participants of the agreement on or in association with the distributed financial transaction platform and, based on the relevant terms thereof, conduct or cause to be conducted secure transactions on the platform for the reallocation. Such a smart contract may be configured with currency distribution instructions and the like, such as digital asset accounts for a payor participant of the agreement (e.g., a buyer) and payee participant of the agreement (e.g., seller), terms and timing of such distributions, and the like. The smart contract, or portions thereof may operate, such as on a processor of one or more servers, IoT devices, and the like to cause the currency distribution to be effected. As an example, an IoT enabled digital currency kiosk may be configured with a portion of a smart contract that controls, at least in part, operation of a fleet of IoT enabled kiosks. The kiosk (or, for example, a processing portion thereof, such as a set of computing logic of the IoT enabled kiosk) may be defined as a participant in the smart contract that can be authorized to receive inputs from other participants (e.g., payors) for conducting transactions of the smart contract. Input received through the kiosk smart contract participant may be shared with other portions of the smart contract, which may optionally be operated by other network-accessible computing systems, and processed according to the currency distribution terms of the underlying agreement embodied as a smart contract.

In examples of a smart contract implementation, a smart contract may be configured to configure and manage the exchange of digital knowledge across marketplaces, exchanges, transaction platforms, and the like. In a value-chain network example, a first marketplace may facilitate raw materials transactions. A second marketplace may facilitate finished goods materials wholesale transactions. A third marketplace may facilitate retail transactions of the finished goods. A smart marketplace exchange contract may be configured with computer executable functionality to process terms of a knowledge-sharing/exchange agreement among some of these marketplaces. As an example, a smart contract may be configured to facilitate exchange of knowledge regarding waste of raw materials resulting from production of finished goods made available in finished goods marketplace(s). Such an exemplary smart contract may further be configured to facilitate sharing other production byproduct information (e.g., carbon emissions and the like) among marketplaces so that pricing and/or terms of purchase of finished goods may be adapted based thereon. A smart contract may be configured to enforce terms of material transfer from one marketplace (e.g., distribution) to another (e.g., retail), such as proper reuse/recycling of packaging material by the retail marketplace. This may be enabled by, for example, packaging location-tracking devices that provide information to the smart contract to ensure packaging material is routed per the terms of the agreement and failure by a party to adhere to such terms will trigger actions of the smart contract, such as retention of a deposit paid for the packaging, increase in automated invoice settlement, and the like.

In examples of a smart contract implementation, a smart contract may be configured to manage Electronic Medical Records (EMR) for various actions/requirements thereof, such as consents, scope of consents, document access, and the like. Access to and use of electronic medical records may be subject to regulatory requirements that are designed to ensure a high degree of privacy, security, and integrity. Access by providers, insurers, billing departments, patients, and the like must comply with a range of authorization that generally stems from patient consent. A smart contract may be configured to operate as a primary control for electronic medical record access based on, for example, patient consent. EMR access systems, such as electronic record systems used by emergency room medical staff and the like, may be configured with one or more consent portals that direct requests for EMR access to an EMR smart contract where at an access request can be processed to ensure that it meets the consent requirements thereof. In embodiments, an EMR smart contract may be configured to detect such access requests (e.g., by a medical imaging system to import a set of medical images (e.g., MRIs and the like) to a patient's EMR). Information in or associated with the request, such as a degree of urgency of the request, a provider making the request, a location of a facility where the records will be viewed (e.g., a domestic office within a patient's home state, a location outside of a home state of the patient, a foreign jurisdiction and the like) and others may be input to control functions of the smart contract that may process the request, determine the required degree and scope of access consent (e.g., an explicit consent given more than the consent validity duration may be deemed an invalid consent except when a life threatening condition of the patient accompanies the request), and based thereon authorize access by a requesting EMR access system. The EMR smart contract may provide automated authorization for access only to records explicitly authorized in a consent to a medical records access management facility participant of the underlying EMR smart contract. The requested records that comply with the consent may, as a result of the smart contract operation, be caused to be made available to an initiator of the request.

In examples of a smart contract implementation, a smart contract may be configured to manage clinical trials. Aspects of clinical trials that a smart contract may be configured to manage may include, without limitation, tracking IRB approvals, patient enrollment and incentive payments, collaboration of physicians and facilities, pharma-related aspects, clinical trial data access, authentication, and the like. In embodiments, a master smart contract may be configured to actively link with other smart contracts that control portions of a clinical trial. As an example, physician collaboration may be controlled by a smart contract to which physicians, facilities, and the like may be participants. This smart contract may interact with a clinical trial master smart contract so that, under the terms of the physician collaboration smart contract, the participant physician may become participants of the master clinical trial smart contract with all of its terms and conditions taken into consideration. Within this example, a physician may opt out of participation in the clinical trial smart contract, but may remain bound by the physician collaboration smart contract for collaboration that is separate from the clinical trial. A master clinical trial smart contract may further link with an intellectual property development engagement smart contract that may control terms under which intellectual property developed for the clinical trial may be owned, controlled, and monetized.

In examples of a smart contract implementation, a smart contract may be configured to manage medical grants. Aspects of medical grants that may be managed by a smart contract include grant funding, grant resources, and grant parties (patients, providers, research institutes, grant providers, government agencies, grant findings consumers, medical field affiliates, Nobel prize record keeping, and the like). A medical grant management smart contract may facilitate control of government grants, industry funded grants, higher-education funded grants, privately funded grants, and the like. A medical grant may be offered with a set of terms and conditions that a grantee must agree to observe for the funding to be provided. These terms and conditions may include a phased set of grant disbursements. A medical grant management smart contract may be configured with interfaces through which participants of such an agreement may provide relevant information for compliance with the terms of a grant. As an example, a medical grant term may require that candidate participants in a portion of the grant complete a qualification questionnaire. An interface to a medical grant management smart contract may be configured to receive each completed questionnaire and/or a summary of completed questionnaires. A grant term compliance function of the smart grant may monitor such an interface to receive and process (e.g., count/validate/document/serialize) questionnaire-related information input to the interface. Such a function may operate cooperatively with a funding disbursement function of the smart contract that may, based on a result of processing the received questionnaire information, determine if and how funds that are conditionally based on satisfaction of a questionnaire term are to be released. Such a funding disbursement function of a smart contract may further interact with a funds disbursement auditing function that, based on an auditor's authorization (optionally an automated authorization), may cause the conditional funds to be disbursed to a grantee account.

In examples of a smart contract implementation, a smart contract may be configured to manage consultants. In embodiments, a consultant management smart contract may facilitate management of consultant administrative aspects, such as consultant payment arrangements and execution, consultant conflict of interest vetting, consultant statement of work agreements, and the like. A consultant administrative management smart contract could receive information from a statement of work agreement (itself optionally a smart contract) that could be used to establish a conflict of interest criteria (that may be embodied as a functional term in a smart contract). Consultants may provide conflict of information vetting information to such a consultant administrative management smart contract (e.g., a list and optional description of current work assignments, work history, current and prior affiliations, and the like). Optionally, a smart contract could employ public and third-party information harvesting services, such as general Internet searches, social-media and business-media information gathering platforms, industry information platforms, consultant referrals, similar consultant information, and the like to gather and optionally vet information for at least one of determining potential conflict items requiring further follow-up (e.g., by a human, artificial intelligence system and the like) and deciding whether a conflict of interest exists for a given consultant. A consultant agreement may further define a conflict of interest petition process by which a consultant could petition to be exempt from some portion of a potential conflict of interest. A corresponding smart contract may automate submission, processing, and authorization (with optional human review) of conflict of interest condition waiver. In examples, a conflict of interest term may identify employment with or consultation for for-profit forestry companies as a conflict. The smart contract may examine government forestry programs that use consultants and/or contracting firms and determine that the specific consultant is/was named as a consultant to one of these programs. A smart contract may further receive and/or retrieve payment information for a relevant government forestry program and automatically determine if the specific consultant is a payee for services to the program. Based on a result of this finding, a smart consultant administrative management contract may reject a petition of waiver or may grant a petition of waiver. The smart contract may handle the waiver petition automatically, and/or with human assistance.

In examples of a smart contract implementation, a smart contract may be configured to track publications, such as publications for which contract terms are established, such as for publication distribution, selling price, and the like. A publication tracking smart contract may be configured to track a wide range of publications, such as digital publications, newsletters, email campaigns, physical publications, newspapers, newsletters, regulatory publications, updates to terms of sale/use, and the like. Terms of a publication agreement may include advance payments to an author to develop the content of the publication. These terms may include demonstrable milestones, such as a minimum number of pages, meetings with editors, and the like within timeframes called out in the agreement. In embodiments, successful completion of milestones may impact other terms of a publication agreement, such as further advance payments, distribution channel priority, and the like. A publication tracking smart contract may be configured with a portal into which an author may submit work product that is intended to demonstrate progress toward one or more milestones. Optionally, a publication tracking smart contract may include methods and systems that monitor deliverable activity, such as a module executing on or in association with an author's writing system (e.g., a personal computer, browser, and the like) that monitors deliverable impacting activity, such as key entries, file updates, and/or time spent working on a deliverable (e.g., a draft manuscript and the like). Deliver-side terms of a smart contract may include deliverables based on a number and timing of copies of a publication delivered to retail outlets (e.g., newsstands, bookstores, and the like). A smart contract may interface with various publication production, delivery, distribution, end-reader sales systems to capture information that may impact a determination of satisfactory progress toward and/or completion of publication delivery terms of such an agreement. Other forms of publication tracking may include an end user portal of the smart contract through which customer touch point activity (e.g., a customer scanning a QR code on a back cover of a publication) may be channeled so that third-party agreements associated with the publication may be maintained.

In examples of a smart contract implementation, a smart contract may be configured to manage media licensing. A smart media license contract may manage a range of media license aspects including without limitation content licensing, music sampling, talent contracting, royalty tracking and distribution, residual tracking, pay-per-play tracking, pay-as-you-go usage, such as within video games, and the like. Configuring a smart media license contract may include configuring a list of content for which the contract defines licensing terms, such as content owner fees, distribution fees, advertiser fees, and the like into one or more data structures. The information in such data structures is accessible by a computing system (e.g., a processor, server and the like) that executes a smart contract algorithm that applies logic representing contract terms (e.g., what each advertise has to pay for ad placement associated with an instance of content) to data representative of content activity, such as delivery and rendering an instance of the content by a video rendering service on a smart phone and the like. A smart media licensing contract may, from time to time, capture information from the data structure, to update compliance with content licensing terms of the contract. In embodiments, a smart content licensing contract, or portion thereof, may be deployed into and/or with a gaming system, game program, or other gaming feature (e.g., virtual reality devices, and the like). A deployed portion of the smart contract may address pay-as-you-go content usage within the scope of game play by the user, such as by updating a portion of the data set to reflect usage view-time of content and related features.

In example implementations, a smart contract may be configured to order supplies or materials. The supplies or materials may be ordered in response to fulfillment of a triggering condition, such as a triggering condition related to an amount of supplies or materials stored, needed, requested, contracted for, and the like. The smart contract may be configured to order the supplies or materials from a predetermined source, such as a particular vendor. The smart contract may be configured to have the supplies or materials sent to a predetermined location, such as an address of a customer, of a supplier, and the like. Attributes of the supplies or materials such as source, cost, amount, quality, etc. may be determined and encoded into the smart contract when the smart contract is created, the smart contract may be updated to retrieve information regarding attributes of the supplies or materials after smart contract creation, and/or the smart contract may include logic that allows the attributes of the supplies or materials to be determined by the smart contract, by the distributed ledger, and/or by a related system or data source. The supplies or materials may include any suitable type of supply or materials, such as raw goods, partially manufactured goods, manufactured goods, natural resources, computational resources, energy resources, and/or data management resources.

In example implementations, a smart contract may be configured to release funds and/or assets to a party. The release of funds and/or assets to a party may be performed in response to fulfillment of a triggering condition, such as delivery of goods and/or services by one or more parties. The funds and/or assets may be predetermined at creation of the smart contract and/or may be determined after creation of the smart contract. The funds may include fiat currency, digital currency, or any other suitable type of currency. The assets may include physical assets such as property, resources, supplies, materials, land, tools, equipment, and/or title to the same. The assets may also or alternatively include digital assets, such as processing power, cloud storage capability, digital signatures, programs, files, data, and the like. The smart contract may include logic configured to determine timing, quantity, quality, source, or any other suitable condition or attribute related to release of the funds and/or assets.

In example implementations, a smart contract may be configured to update a government/regulatory database. The government or regulatory database may be updated in response to fulfillment of a triggering condition, such as fulfillment or lack of fulfillment of one or more regulatory requirements by one or more parties. The government or regulatory database may include any suitable database, such as a municipal database, a state database, a federal database, a foreign database, a database of a government agency, and the like. The database may be updated with any suitable data, such as data related to one or more parties to the smart contract, data related to one or more entries on the distributed ledger, data related to one or more amounts of currency and/or pieces of physical or digital property, etc.

In example implementations, a smart contract may be configured to issue a notice of breach to a party. The notice of breach may be issued in response to fulfillment of a triggering condition, such as a material noncompliance with terms of an agreement by one or more parties to the agreement. The smart contract may be configured to automatically detect breach by a party, such as by monitoring one or more conditions related to breach. An example of a condition related to breach may be nonpayment by a party by a particular date and/or time. Another example of a condition related to breach may be failure to deliver or adequately deliver goods and/or services according to one or more terms of an agreement between parties. The notice of breach may include a transmission to the breaching party, such as by email, facsimile, instant message, text message/SMS, post on a website and/or social media, traditional mail, publication (e.g., in a newspaper), process server, and/or any other suitable means of issuing a notice of breach.

In example implementations, a smart contract may be configured to change an exchange rate between currencies and/or tokens. The change in exchange rate between currencies and/or tokens may be performed in response to fulfillment of a triggering condition, and/or may be performed at one or more predetermined times, such as according to a schedule. An example of a triggering condition that may trigger change of an exchange rate by the smart contract may be a value of one or more currencies and/or tokens changing, such as the values thereof exceeding a threshold. The currency may be a fiat currency, a digital currency, or any other suitable type of currency. The token may be a digital token representing a digital currency, a digital token representing ownership or rights to one or more digital and/or physical goods, a digital token representing a program, a digital token representing information stored on the distributed ledger, or any other suitable type of token.

In example implementations, a smart contract may be configured to increase or decrease an interest rate. The increase or decrease in an interest rate may be performed in response to fulfillment of a triggering condition, such as payment of a predetermined amount of debt by a party to an agreement and/or making of a down payment above a threshold by a party to an agreement. The increase or decrease may be made to an interest rate of any suitable type of loan or security agreement. The increase or decrease of the interest rate may be made by adjusting one or more interest related to an agreement transacted on the distributed ledger or an agreement transacted separate from the distributed ledger, such as by a bank or mortgage company.

In example implementations, a smart contract may be configured to initiate and/or perform foreclosure on a piece of collateral. The foreclosure may be initiated and/or performed in response to a fulfillment of a triggering condition, such as default by a party to an agreement in collateral is used to secure a loan. The foreclosure may be initiated and/or performed according to terms encoded into the smart contract. The foreclosure may be initiated and performed by the smart contract itself, or may be initiated by transmitting an initiation signal external to the smart contract, such as to a financial institution.

In example implementations, a smart contract may be configured to place a lien on a piece of property involved in an agreement. The lien may be placed upon creation of the smart contract and/or upon configuring of the contract with terms of an agreement made between a plurality of parties. The lien may be placed in response to fulfillment of a triggering condition, such as use of a piece of digital and/or physical property to secure a loan agreement. The lien and/or conditions related to the lien may be stored on the distributed ledger and/or may be encoded into the smart contract. The lien may be placed on a digital item that is stored on the distributed ledger. The smart contract may additionally include one or more conditions related to release of the lien upon fulfillment thereof.

In example implementations, a smart contract may be configured to record a change in title. The title may be a title to one or more instances of digital property, one or more instances of physical property, one or more instances of real property, or a combination thereof. The change in title may be recorded in response to fulfillment of a triggering condition, such as transfer of property from one or party to another in an agreement, or such as payment or rendering of services by one party of an agreement in exchange for property by another party to the agreement. The title may be stored on the distributed ledger. The recordation of change in title may be performed by transmission of one or more signals and/or documents to one or more recipients external to the distributed ledger, such as to a county registrar or to a digital title database.

In example implementations, a smart contract may be configured to make a UCC filing. The UCC filing may be made to any suitable recipient, such as a government office. The UCC filing may be made in response to fulfillment of one or more triggering conditions, such as acquiring of an interest in the property of a first party by a second party according to an agreement between the first and second parties. The agreement may be stored in the smart contract. The UCC filing may be made by transmitting one or more signals and/or documents to a suitable recipient. The UCC filing may be stored on the distributed ledger.

In example implementations, a smart contract may be configured to extinguish a UCC filing. The UCC filing may be extinguished by transmitting a signal, digital document, or any other suitable notice or data to a suitable recipient, such as a government office. The UCC file may be extinguished in response to fulfillment of one or more triggering conditions, such as payment of a debt by a first party to a second party, the payment of the debt calling for release of an interest of the second party in a piece of property owned by the first party according to terms of an agreement. The agreement may be encoded in the smart contract.

In example implementations, a smart contract may be configured to allocate payments among multiple parties. The allocation of payments may be performed in response to fulfillment of one or more triggering conditions, such as initiation of an agreement between the parties amongst whom the payments are to be allocated. Another example of a triggering condition that may cause the smart contract to allocate payments among multiple parties is delivery of goods and/or services by one or more of the parties to whom payments are to be allocated. The payments may be allocated according to terms encoded in the smart contract, stored on the distributed ledger, and/or external to the distributed ledger. The payment may be allocated according to payment terms encoded in the smart contract at creation of the smart contract, upon agreement between the multiple parties, or at any time or upon fulfillment of any suitable condition.

In example implementations, a smart contract may be configured to allocate profits among joining owners. The allocation of profits may be performed according to a formula, such as terms of an ownership and/or partnership agreement that may be encoded in and/or imported to the smart contract. The formula and/or agreement may be stored on the digital ledger. The formula and/or agreement may be of any suitable type, such as ownership of a business, ownership of one or more securities, co-investment in one or more types of tangible and/or intangible properties and/or securities, and the like.

In example implementations, a smart contract may be configured to make a payment. The payment may be made in response to fulfillment of one or more triggering conditions, such as according to a payment schedule of an agreement between parties. The payment may be made by transferring one or more digital currencies and/or balances stored on the digital ledger. Additionally or alternatively, the payment may be made by transmitting a signal such as a wire transfer signal to a recipient outside of the distributed ledger network, such as to a bank. The payment may be made to one or more parties to an agreement encoded in the smart contract, and/or may be made to one or more parties for the sale, license, lease, and/or transfer of goods stored on the distributed ledger.

In example implementations, a smart contract may be configured to send a gift. The gift may be sent in response to fulfillment of one or more triggering conditions, such as at a certain date or time. The gift may be sent from one party to another and/or to or from any users of the distributed ledger, parties to agreements stored thereon, and/or owners or lessees of digital property and/or currency stored thereon. The gift may include digital currency and/or property, fiat currency, physical property, title to digital and/or physical property, or any other suitable gift.

In example implementations, a smart contract may be configured to trigger a gaming event. The gaming event may be triggered in response to fulfillment of a triggering condition, such as achievement of one or more gaming incentive goals by one or more parties to an agreement encoded in the smart contract. For example, parties may engage in an agreement encoded in the smart contract for the sale of goods, wherein upon selling a set increment of goods a party may receive one or more game incentives, such as digital game tokens. The gaming event may be related to any suitable game, such as a gamification of a sale or contract. The gaming event may include awarding game incentives such as digital currency to one or more users of the distributed ledger.

In some implementations, smart contracts may be configured, for example, to confirm receipt of a shipment at a delivery location, instantiate another smart contract or sequence of smart contracts, manage franchise agreements (such as tracking and applying franchise rules), manage government contracts, manage real estate (such as managing mortgages and lending, title, insurance, or the like), manage transportation assets (such as managing title, insurance, emissions, or the like), manage financial contracts, manage corporate agreements (such as statements of work, purchase agreements, employment agreements, mergers, acquisitions, insurance, or the like), track data privacy, manage wills or trusts, perform outcome-dependent transactions, or the like.

In some implementations, smart contracts may be invoked upon the occurrence by one or more of the following events: social media events, social impact measurements (including number of followers, number of posts, number of likes, number of views, or the like), weather or disaster events (including severe weather damage, crop destruction, fires, floods, pandemics, earthquakes, hurricanes, war, or the like), the purchase of a product or service, changes related to collateral (including tokenization of collateral, movement of collateral, damage to collateral, depreciation of collateral, or the like), covenant events (such as bonds or loans linked to IoT devices), machine-to-machine events (including digital twins contracting with each other, IoT agents contracting with each other, machine-to-machine or digital twin payment network events, or the like), advertising events, marketing events, gaming events, quantum services events, sporting events, gambling events, security events, energy markets events, and product release events.

In embodiments, the platform 2400 may present a GUI to a user that requests to generate a new smart contract. In embodiments, the platform 2400 may provide a set of smart contract templates that the user may select based on the type of transaction that the user has requested. For example, if the marketplace is configured for buying and/or selling interests in real property, the platform 2400 may provide the user with one or more options for generating smart contracts that relate to real estate transactions. The user may be given a set of questions that, when answered, result in the platform 2400 selecting the smart contract template that is optimized for the user's intentions (e.g., a lending-based smart contract template, a smart contract template governing the sale of an interest in a real estate property, a commodity trading smart contract template that governs a forward contract, or the like). Alternatively, the user may be provided with a menu of available smart contract templates, and the user may select one of the smart contract templates from the menu.

Upon determining a smart contract template, the platform 2400 may provide an interface (e.g., a GUI) that allows a user to set the parameter values corresponding to the determined smart contract template. For example, in a smart contract governing a futures contract with respect to a commodity, the user may set the type of commodity, a number of units (e.g., barrels of oil, bushels of wheat, ounces of gold, or the like), a contract price to be paid for the commodity, the execution date of the futures contract, the contract price, and other suitable parameter values. In examples, in a smart contract governing the sale of a physical asset, the seller may set a first price if a buyer is located within the United States and a second price if the buyer is located outside the United States. In this example, the user sets parameter values that are used to parameterize triggers, namely a geographical restriction. In this example, the platform 2400 may generate a smart contract that has location-sensitive pricing. Thus, when a buyer seeks to accept the terms of the smart contract, the smart contract may verify a location of the potential buyer and may configure the terms of the contract (e.g., the price and/or other suitable terms, such as logistics information, location-specific tax information, or the like) based on the location of the potential buyer. It is noted that in other examples, users may parameterize smart contracts with parameter values corresponding to triggering actions, such as initiating a certification process associated with the transaction, initiating a reporting process associated with the transaction, configuring logistics information associated with the transaction, reconfiguring of terms (e.g., premium rates, interest rates, contract price, delivery date, payment due date, and/or the like). It is appreciated that depending on the type of smart contract, the types of data that may be used to parameterize a smart contract will differ. As with the other embodiments the involve parameterization, parameterization may be undertaken by robotic process automation or other artificial intelligence systems, such as trained on a training set involving parameterization by a set of experts.

In some implementations, a smart contract may include one or more event listeners. In embodiments, an event listener may be a listening thread that monitors one or more data sources to determine when a certain event occurs, such as whether a triggering condition is met. In embodiments, an event listener may subscribe to a data feed, query an API, receive notifications, query a database or other data source, passively receive data from a set of Internet of Things (IoT) devices (consumer IoT devices and/or industrial IoT devices and/or sensors), or otherwise receive/retrieve data from a data source to obtain a specific type or types of data. For example, a smart contract governing an insurance policy that covers an industrial facility may include an event listener that queries a municipality database, such as via an API, to verify that the owner of the industrial facility has paid its taxes and to identify the presence of changes in title, liens, or encumbrances on the property. Continuing the example, a smart contract governing the insurance contract may include an event listener that connects to an industrial internet of things (IIoT) sensor system (or “sensor system”) of the industrial facility to receive one or more sensor streams. For example, the smart contract may be parameterized with a set of IP addresses and authentication credentials to access a sensor system (e.g., via a set of edge devices of the sensor system) to access a set of data streams from the sensor system. In some embodiments, an edge device of the sensor system may include an intelligence system that filters the stream (such as to deliver information relevant to the smart contract parameters while omitting unnecessary information) and/or performs one or more analytic operations on the sensor data collected from a set of one or more sensors (such as to calculate a metric that is used as a parameter of the smart contract) and may communicate one or more data streams based on the filtering and analytics to the system hosting the smart contract. The smart contract event listener may listen to such streams to verify one or more triggering conditions. In this way, the smart contract may ingest sensor data and determine whether one or more triggers have occurred. In response to determining that a defined set of triggers have occurred, the smart contract may execute one or more smart contract actions. For example, in the context of an insurance contract, the detection of a warning condition by the smart contract that is derived from sensor data received from a sensor system associated with an industrial facility may result in an action that adjustments a premium rate of the insured. In this way, the smart contracts may be configured to receive IoT data (e.g., IoT-collected sensor data, IoT-collected health data, IoT-collected location data, and/or the like) to verify one or more triggers and, in response, to initiate one or more smart contract actions. It is appreciated that smart contract event listeners according to other example embodiments of the disclosure may listen for data obtained from additional or alternative data sources.

In embodiments, the platform 2400 can support smart contracts of a number of different types for a number of different types of marketplaces. As used herein, references to “supporting smart contracts” may refer to the platform 2400 generating and deploying a smart contract on behalf of a user and/or facilitating the generation of smart contracts by users of the platform 2400 in a decentralized manner (e.g., generated from a user device that writes the smart contract to a distributed ledger), as well as generating and deploying a smart contract automatically, such as by an artificial intelligence system and/or set of services (e.g., involving robotic process automation) within the platform 2400 or linked to the platform 2400, such as via one or more interfaces, such as application programming interfaces. Examples of types of marketplaces/transactions that may be supported by the platform 2400 may include, but are not limited to, asset-based transactions, insurance transactions, supply-chain transactions, commodity/stock-based transactions, cryptocurrency transactions, intellectual property transactions, and/or any other types of transactions described herein or in the documents incorporated by reference herein, and may include the core transactions that characterize marketplaces (e.g., purchase and sale of bonds in an equities market), as well as other transactions, such as microtransactions and exchanges that are involved in workflows or processes (e.g., a transfer of value in exchange for priority within a prioritization system, providing value to induce behavior, such as viewing an advertisement, and many others), and many others.

In some embodiments, the platform 2400 may support smart contracts that govern transactions involving assets. In these embodiments, a smart contract may include information defining the asset (e.g., an asset identifier, a serial number, a name, a make/model, or the like) or assets that are subject to the transaction, the price of the asset, the number of units, or the like. Furthermore, as the smart contract may be generated by a buyer, a broker, a market maker, a seller, or the like, the smart contract may or may not define the parties to the transaction, or the types of parties that are permitted to transact (e.g., limiting to licensed broker/dealers for transactions in regulated securities where required). For instance, a buyer wishing to purchase a vehicle may generate a new smart contract via the platform 2400 that offers a price to purchase a particular vehicle (e.g., make, model, and year) with one or more additional requirements (e.g., <50,000 miles, single owner, under warranty, pickup location/area, and/or the like). In this example, there is no seller identified in the smart contract, but the buyer may be identified in the smart contract. In response, the platform 2400 may generate a smart contract that includes the triggering conditions for completing the sale of the vehicle and a smart contract action that initiates the transfer of title from the seller to the buyer. This may include an event listener or other smart contract element that requires the buyer to prove that he or she has the cash and/or adequate financing to purchase the vehicle and an event listener or other smart contract element that requires a seller to prove that they have title to a vehicle meeting the buyer's requirements. In embodiments, the platform 2400 may be configured to use automation systems, such as artificial intelligence, such as one or more classification systems that is trained, such as using a model and/or a training set of human-labeled data, to discriminate between valid and invalid inputs that are offered to satisfy applicable triggers in the smart contract. For example, such systems may be trained to process account data to determine adequacy of adequate financial strength of the buyer and to process title records (e.g., title certificates) to determine the adequacy of the seller's claim to title. Such artificial intelligence systems used for classification may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein. In this example, the prospective buyer may upload a document that proves that he or she has secured financing to cover the defined price and the seller can upload a copy of the title of the vehicle as well as a certified statement declaring that the other requirements are met. Alternatively, if the vehicle is a connected vehicle, the seller may provide access to the vehicle data, whereby the warranty status and the mileage of the vehicle may be confirmed.

In embodiments, the platform 2400 may support smart contracts that govern insurance policies. In embodiments, an insurance policy smart contract may be generated in response to a party seeking to insure an asset, a property, a business, a person, or the like. Insurance policies may take any form of insurance, such as health insurance, life insurance, homeowner's insurance, disaster insurance (e.g., fire, flood, hurricane, pandemic, or the like), property insurance, auto insurance, third party liability insurance, business interruption insurance, disability insurance, or the like. In a specific example, a party may agree to a set of terms provided by an insurance provider. In this example, the insurance provider may agree to reduce the premium rates as long as the insured agrees to provide one or more requested data types. In some embodiments, the requested data types may be one or more data streams from a set of IoT devices associated with the insured. For instance, in insuring an industrial facility, the smart contract governing the insurance policy may be configured to receive a data stream of sensor data from an IIOT sensor system distributed within the industrial facility. Either the smart contract, the platform 2400, a third-party service, or an edge device of the sensor system may receive the raw sensor data from the IIoT sensor system and may determine whether the sensor data indicates a deteriorating condition of the facility or a piece of industrial equipment within the facility. In the example, the smart contract may reconfigure the terms of the insurance policy to a provide for a higher premium and/or deductible until the deteriorating condition is resolved (as indicated by the sensor data). In examples, a smart contract governing a health insurance policy may be configured to receive health-related data from a wearable device of the insured individual. In this example, the smart contract may be configured to lower the premium rate if the health-related data indicates that the user is taking actions to improve his or her health. For instance, if the health-related data includes a number of daily steps and the number of daily steps over a period of time (e.g., six months) indicates that the user is taking at least 10,000 steps a day, the smart contract may reduce the premium of the individual by an agreed upon amount (e.g., 100 dollars a month). Conversely, if the smart contract receives negative health-related data (e.g., high blood pressure, low blood oxygen, less than 1000 steps a day over a six month period, or the like) or if the user does not provide the health-related data (e.g., does not grant access to the wearable device), the smart contract may increase the premium to an agreed upon amount.

In some embodiments, the platform 2400 is configured to bind parties to smart contracts via a digital twin, such as where the digital twin offers interfaces that are integrated with and/or linked to the platform 2400, that are shared with the platform 2400, and/or the like. A digital twin platform may be integrated with or into the platform 2400 and/or linked to it, such that the digital twin platform and the platform 2400 share data sources, resources, services, interfaces and the like, including data sources that are accessed to determine triggers for the smart contract and thereby facilitating triggering of actions in the digital twin (and in turn various services, systems, processes and the like that may be controlled by or from the digital twin) in response to actions determined by the smart contract. For example, an ownership transfer of an asset may be affected by a smart contract and automatically reflected in a digital twin that represents the asset, such as by a change in data, metadata, or the like in the data schema that is used to generate the digital twin. In embodiments, the platform 2400 may be configured to serve transaction offers to users in a digital twin (e.g., an “in-twin” marketplace) via an API. In response to a user agreeing to an offered transaction, the user may be committed to a smart contract. In some embodiments, the user may be required to provide additional information and/or access to certain types of data pursuant to the smart contract.

In embodiments, the platform 2400 may support smart contracts that are deployed in connection with forward contracts that are traded via asset trading marketplaces (e.g., commodity trading marketplace, stock trading marketplace, or the like). In embodiments, a trading marketplace may refer to a marketplace that is created to facilitate the brokering of forward contracts. In embodiments, a user may create a smart contract governing a forward contract. In embodiments, a user may select an option to create a new smart contract governing a forward contract. In some of these embodiments, the user may be presented a GUI to provide one or more parameter values. For instance, the GUI may include fields for the user to identify an asset (e.g., a stock or commodity), the long party/buyer, the short party/seller, a contract settlement date, and/or a price (e.g., price per unit or a total price). In this example, the user setting the forward contract may be the short party (e.g., buyer), the long party (e.g., seller), or a third party (e.g., a broker). In the case that either the short party or long party is to be determined, the field may be left unparameterized and may be parameterized when the to be determined party commits to the forward contract. Upon receiving the parameterization values, the platform 2400 may deploy the smart contract (e.g., to a distributed ledger and/or platform 2400 may execute the smart contract). Furthermore, to the extent that one or more parties remain unresolved, platform 2400 may publish the offer of the future contract with a defined price via a corresponding marketplace (e.g., a forward contract marketplace, a commodity marketplace, or an equities marketplace). In embodiments, the platform 2400 may generate and deploy a smart contract in connection with a forward contract automatically, such as by an artificial intelligence system and/or set of services (e.g., involving robotic process automation) within the platform 2400 or linked to the platform 2400, such as via one or more interfaces, such as application programming interfaces.

In some embodiments, the platform 2400 may create and host forward marketplaces. In embodiments, a forward marketplace may refer to an electronic marketplace that provides a medium for counterparties to negotiate and engage in forward contracts. A forward contract may refer to a customized contract between two parties to buy/sell a negotiated quantity of an asset at a negotiated price on a negotiated date. Examples of assets that may be sold using forward contracts include agricultural commodities (e.g., wheat, corn, oranges, cotton, and/or the like), natural resources (e.g., natural gas, oil, gold, silver, platinum, or the like), financial instruments (e.g., stocks, bonds, currencies, or the like), non-traditional assets and/or other suitable commodities (e.g., fuel, electricity, energy, computational resources (e.g., quantum computational resources), cryptocurrencies, defined income streams, data streams (such as sensor data, network data and the like), knowledge structures, and the like. In some embodiments, a future contract may require additional terms, such as a delivery location and/or storage location for the assets (if physical assets to be delivered/stored), warranties and/or guarantees (e.g., warranties that the assets will meet certain requirements), or the like. In embodiments, the forward marketplace may provide an interface where parties may negotiate the terms of a forward contract. For example, a first party/user may create an initial offer that includes a set of terms (e.g., asset, quantity, contract expiration date, price, and any other negotiable terms). In response, the forward marketplace may present the offer to the counterparty, which may accept the offer, reject the offer, and/or submit a counteroffer (e.g., by changing one or more terms). The parties may iterate via the forward marketplace in this manner until an offer or counteroffer is accepted or the deal is rejected. In response to the parties agreeing to a forward contract (e.g., one party accepts the other party's bid), the platform 2400 may generate a forward contract based on the negotiated terms. In some embodiments, a forward contract may be formed between parties using the forward marketplace via a bidding process. In these embodiments, a party may generate an offer to buy/sell a set quantity of an asset at a set price on a set date. For example, a seller may offer to sell 10000 bushels of wheat at five dollars a bushel on Nov. 5, 2020. The forward marketplace may publish the offer, such that potential counterparties may view the offer. It is appreciated that the forward market may provide additional information in connection with the offer, such as a rating of the party that generated the offer. If a potential counterparty accepts the offer, the platform 2400 may generate a forward contract between the parties. In a variation of the bidding process, a listing party may define a specific quantity of a specific asset to be completed on a proposed date, and counterparties may provide bids that indicate a price of the contract. For example, a buyer may offer to buy 10000 bushels of wheat on Nov. 5, 2020. In response, potential sellers may offer different prices for the requested asset. Continuing this example, a first seller may offer to a price of four dollars a bushel and a second seller may offer five dollars a bushel. The listing party may then accept one of the bids (e.g., the buyer may accept the four dollar a bushel price). In response to an offer being accepted, the platform 2400 may generate a future contract based on the negotiated terms. In embodiments, the platform 2400 may create and host forward marketplaces automatically, such as by an artificial intelligence system and/or set of services (e.g., involving robotic process automation) within the platform 2400 or linked to the platform 2400, such as via one or more interfaces, such as application programming interfaces.

In embodiments, a forward market orchestration system platform 2400 is configured to generate smart contracts governing forward contracts in response to a completed negotiation process via a forward marketplace. As discussed, a listing party may publish an offer, engage in a series of offers and counteroffers, and/or request offers for a forward contract relating to an asset during the negotiating process. Once an offer has been accepted by both parties (or three or more, depending on the parameters of the contract), the platform 2400 may generate a smart contract and may parameterize the smart contract based on the parameters defined in the accepted offer (e.g., the party that made the bid, the party that accepted bid, the assets at issue, the quantity of assets, the contract price, the contract settlement date, and any other suitable parameters). In some embodiments, the platform 2400 may deploy the smart contract once generated (e.g., to a distributed ledger and/or internally). In embodiments, the smart contract may be configured with an event listener that listens for events associated with the forward contract and triggers actions based thereon. For example, an event listener may be configured to listen for a date, and when the date reaches the contract settlement date, the smart contract may initiate the transfer of funds from the buyer to the seller and/or the transfer of the assets to the buyer from the seller. Additionally or alternatively, an event listener may be configured to listen for a payment from the buyer to the seller and/or delivery of the assets from the seller to the buyer. If either of the conditions is not met, such as within a time period parameter defined within the smart contract, the smart contract may be configured to initiate a process that handles default scenarios (e.g., automatically transferring funds from the defaulting party to the counterparty from an account of the defaulting party).

It is appreciated that trading marketplaces may support smart contracts that govern other financial trading instruments, such as options, swaps (e.g., credit/default swaps, in-kind exchanges, and the like), futures, derivatives, and the like without departing from the scope of the disclosure. In embodiments, in generating smart contracts that govern options, a smart contract may be configured to listen for events related to the option. For example, if an option is triggered when the price of a particular commodity, financial instrument, or index reaches a triggering value, the option may be automatically executed. Similarly, the option may automatically vest (i.e., become exercisable) upon a trigger condition, which may include any of the triggers noted herein. In the example of a smart contract listening for a price trigger, an event listener of a smart contract that governs an option may be configured to receive data from a commodity or stock marketplace and to compare the current price of the commodity to the triggering value, such that when the current price reaches the triggering value, the smart contract may execute one or more actions that exercise the option in accordance with the agreed upon terms of the option contract.

In embodiments, the market orchestration system platform 2400 may cluster a set of smart contracts by attribute similarity. In embodiments, smart contract attributes may include smart contract types (e.g., smart legal contracts, decentralized autonomous organization (DAO) smart contracts, application logic contracts (ALCs), ancillary smart contracts and many others), programming language type (Solidity, Rust, JavaScript, Vyper, Yul, and many others), transaction types (e.g., payment of funds upon certain triggering events, imposing financial penalties if certain objective conditions are not satisfied, and many others), smart contract function types, parties or party types subject to the smart contracts, number of parties subject to the smart contracts, relevant chain(s) related to the smart contracts, assets or asset types subject to the smart contracts, asset volumes covered by the smart contracts, total monetary value of the smart contracts, pricing related to the smart contracts, events related to the smart contracts, conditions related to the smart contracts, smart contract timing attributes, smart contract statuses (e.g., pending, executed, abandoned, and the like), smart contract terms, likelihood of execution, transaction fees, off-chain resources (i.e., information or parameters from resources that are not on the blockchain), oracles, and many others.

In embodiments, the market orchestration system platform 2400 may leverage the artificial intelligence system to cluster a set of smart contracts by attribute similarity. In embodiments, an artificial intelligent services system 2143 receives an intelligence request and any required data to process the request from the market orchestration system platform 2400. In response to the request and the specific data, one or more implicated artificial intelligence system perform the intelligence task and output a clustering of the set of smart contracts by attribute similarity.

For example, the intelligent services may receive data from various sources described throughout this document and the documents incorporated by reference herein and may generate a set of feature vectors based on the received data. The intelligent services system 2143 may input the set of feature vectors into a machine-learned model (e.g., using a combination of simulation data and real-world data) to cluster a set of smart contracts by attribute similarity by a set of human experts and/or by the other systems or models. Data sources and feature vectors used for smart contract clustering may include marketplace smart contract data, asset data, user data, transaction data, as well as external data sources (such as publicly available smart contract data) and many others. Such artificial intelligence systems used for clustering, in the present example and other examples described herein, may include a recurrent neural network (including a gated recurrent neural network), a convolutional neural network, a combination of recurrent neural network and a convolutional neural network, or other types of neural network or combination or hybrid types of neural network described herein or in the documents incorporated by reference herein.

In embodiments, machine learning and/or artificial intelligence models may be trained using existing public facing smart contracts to determine clustering and high-level meta tags.

In embodiments, outliers within a cluster of smart contracts may be highlighted or otherwise presented to a user. For example, buy-side bond purchase smart contracts may be assigned to a cluster to reveal price outliers.

In embodiments, the market orchestration system platform 2400 may leverage the intelligent services system 2143 (such as artificial intelligence system, RPA module and/or NLP module) to automatically convert discussions into a smart contract. In embodiments, discussions may include email discussions, instant messaging and/or chat discussions, text messaging discussions, video conferencing discussions, phone call discussions, and many others. For example, an agreement captured in a video conference to keep the video conference discussion confidential may be captured and applied to the video conference discussion as a wrapper.

In embodiments, the market orchestration system platform 2400 may provide visual representations of relevant terms and/or conditions from a set of smart contracts and/or proposed smart contracts. Such visual representations may be presented to the user via a set of digital twins, the user interface of an application, a wearable, an augmented reality headset, a virtual reality headset, and many others.

For example, a digital twin accessed by a trader (e.g., a trader digital twin, a digital twin of the trader's account, a digital twin of a marketplace, a digital twin of a set of smart contracts, or the like) may present visual representations of the relevant terms and/or conditions of a set of smart contracts related to buy-side asset purchases, such as smart contract duration, decision points, pricing, current position exposure, risk, liquidity, and the like. In embodiments, the digital twin may also present recommendations, such as for risk mitigation (e.g., hedging or insurance), termination, amendment, expansion, or the like. In embodiments, such recommendations may be represented visually via the digital twin.

In embodiments, the market orchestration system platform 2400 may execute simulations relating one or more terms and/or conditions from a set of smart contracts or proposed smart contracts and present such simulations and/or the results of such simulations to the user via a user interface.

In some embodiments, the market orchestration system platform 2400 may leverage the intelligent services system 2143 to provide data stories about relevant terms and/or conditions from a set of smart contracts and/or proposed smart contracts. Continuing the example, a machine learning and/or artificial intelligence system may generate an audiovisual data story based on the set of smart contracts and/or proposed smart contracts and output the generated audiovisual data story to the market orchestration system platform 2400. In embodiments, the market orchestration system platform 2400 may be configured to enable presentation of the data story to a user via a user interface, such as the user interface of a digital twin or the user interface of a digital wallet. In embodiments, the audiovisual data story may include the results of various simulations related to the set of smart contracts and/or proposed smart contracts.

In embodiments, the intelligent services system 2143 performs machine learning, artificial intelligence, intelligent order matching, counterparty discovery, counterparty intelligence, analytics tasks, and/or any other suitable tasks on behalf of the platform 2400. In embodiments, the intelligent services system 2143 includes a machine learning system that trains machine learned models that are used by the various systems of the platform 2400 to perform intelligence tasks, including robotic process automation, predictions and forecasts, classifications (including behavioral classifications, type determination and others), process control, monitoring of conditions, translation (such as language translation), natural language processing, prescriptive analytics, and the like. In embodiments, the platform 2400 includes an artificial intelligence system that performs various AI tasks, such as automated decision making, robotic process automation, and the like. In embodiments, the platform 2400 includes an analytics system that performs different analytics across marketplace data to identify insights related to the states of a marketplace, marketplace assets, traders, and the like. For example, in embodiments, the analytics system may analyze the performance data, condition data, sensor data, or the like with respect to a physical asset to determine whether the asset is in excellent condition, satisfactory condition, or in poor condition. In embodiments, the analytics system may perform the analytics in real-time as data is ingested from the various data sources to update one or more states of a marketplace asset. In embodiments, the intelligent services system 2143 includes a robotic process automation system that learns behaviors of respective users and automates one or more tasks on behalf of the users based on the learned behaviors. In some of these embodiments, the robotic process automation system may configure intelligent agents 2134 on behalf of a marketplace host, trader, broker, or the like. The robotic process automation system may configure machine-learned models and/or AI logic that operate to generate outputs, such as ones that govern actions or provide inputs to other systems, given a set of stimuli. In embodiments, the robotic process automation system receives training data sets of interactions by experts and configures the machine-learned models and/or AI logic based on the training data sets. In embodiments, the intelligent services system 2143 includes a natural language processing system that receives text/speech and determines a context of the text and/or generates text in response to a request to generate text. The intelligent services are discussed in greater detail throughout the disclosure and the documents incorporated herein by reference.

In embodiments, the intelligent services system 2143 performs machine learning, artificial intelligence, and analytics tasks on behalf of the platform 2400. In embodiments, the intelligent services system 2143 includes a machine learning system that trains machine learned models that are used by the various systems of the platform 2400 to perform some intelligence tasks, including robotic process automation, predictions, classifications, natural language processing, and the like. In embodiments, the platform 2400 includes an artificial intelligence system that performs various AI tasks, such as automated decision making, robotic process automation, and the like. In embodiments, the platform 2400 includes an analytics system that performs different analytics across data sources, such as enterprise data, to identify insights to various states of a marketplace. For example, in embodiments, the analytics system may analyze the financial data of an asset to determine whether the asset is financially stable, in a critical condition, or a desirable condition. In embodiments, the analytics system may perform the analytics in real-time as data is ingested from the various data sources to update one or more states of a market orchestration digital twin. In embodiments, the intelligent services system 2143 includes a robotic process automation system that learns behaviors of respective users and automates one or more tasks on behalf of the users based on the learned behaviors. In some of these embodiments, the robotic process automation system may configure expert agents on behalf of a marketplace and/or marketplace entities, such as users, a set of hosts, service providers, infrastructure providers, information technology providers, information providers, and others. The robotic process automation system may configure machine-learned models and/or AI logic that operate to generate outputs, such as ones that govern actions or provide inputs to other systems, given a set of stimuli. In embodiments, the robotic process automation system receives training data sets of interactions by experts and configures the machine-learned models and/or AI logic based on the training data sets. In embodiments, the intelligent services system 2143 includes a natural language processing system that receives text/speech and determines a context of the text and/or generates text in response to a request to generate text. The intelligent services are discussed in greater detail throughout the disclosure.

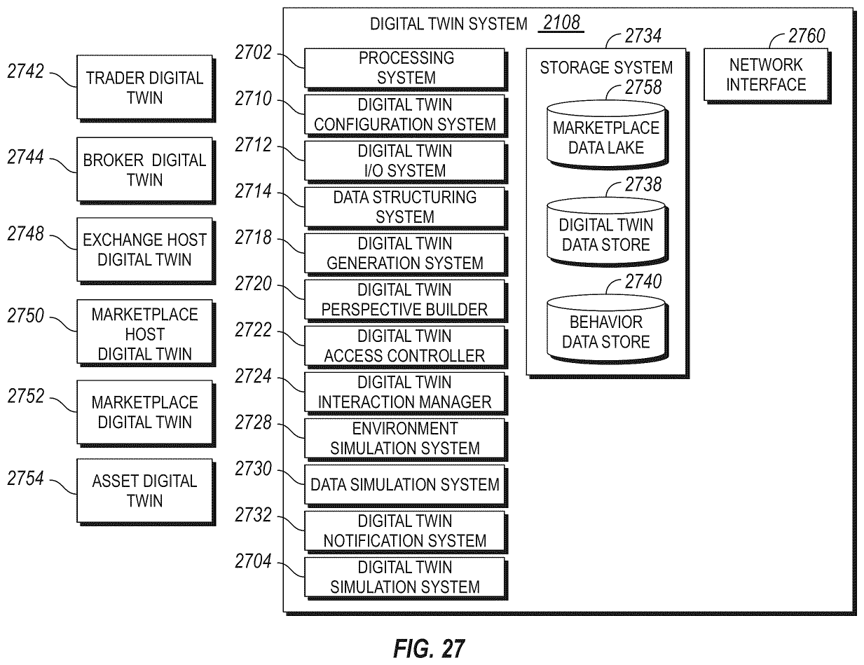

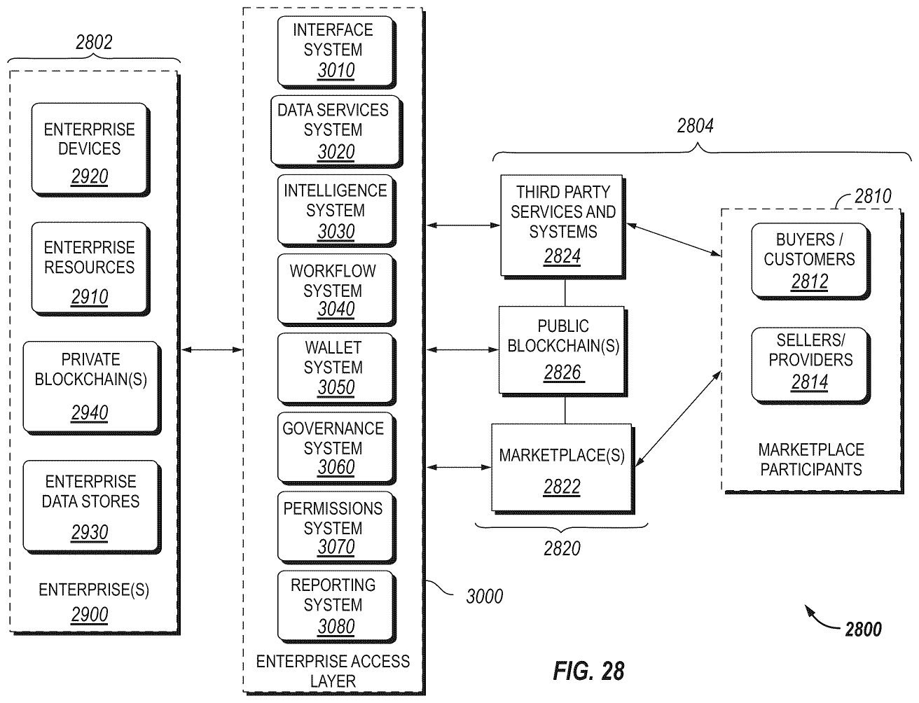

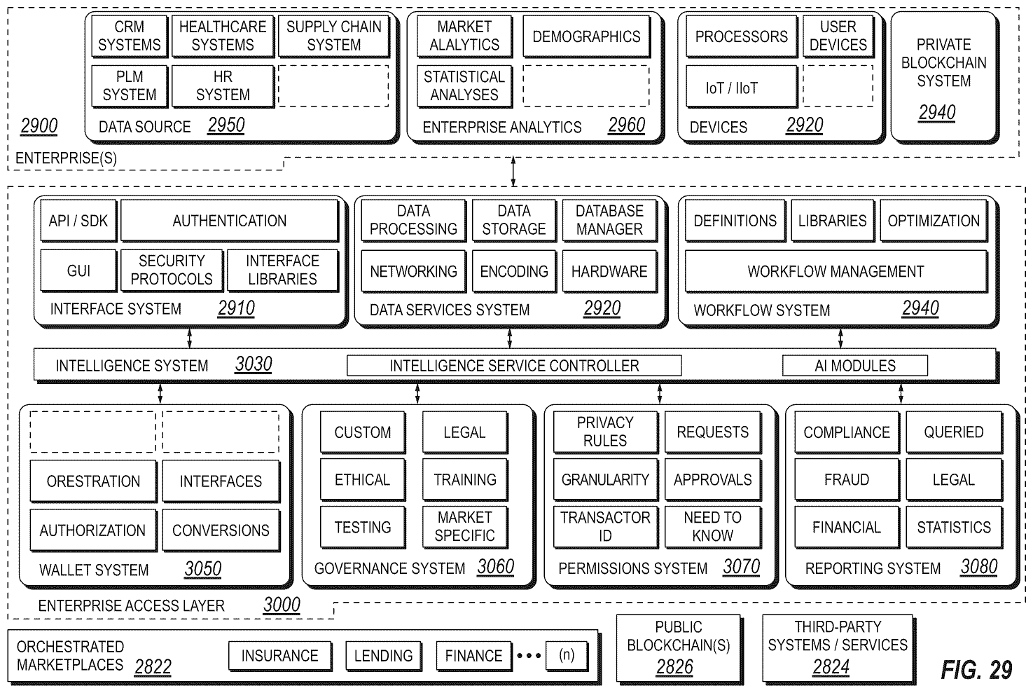

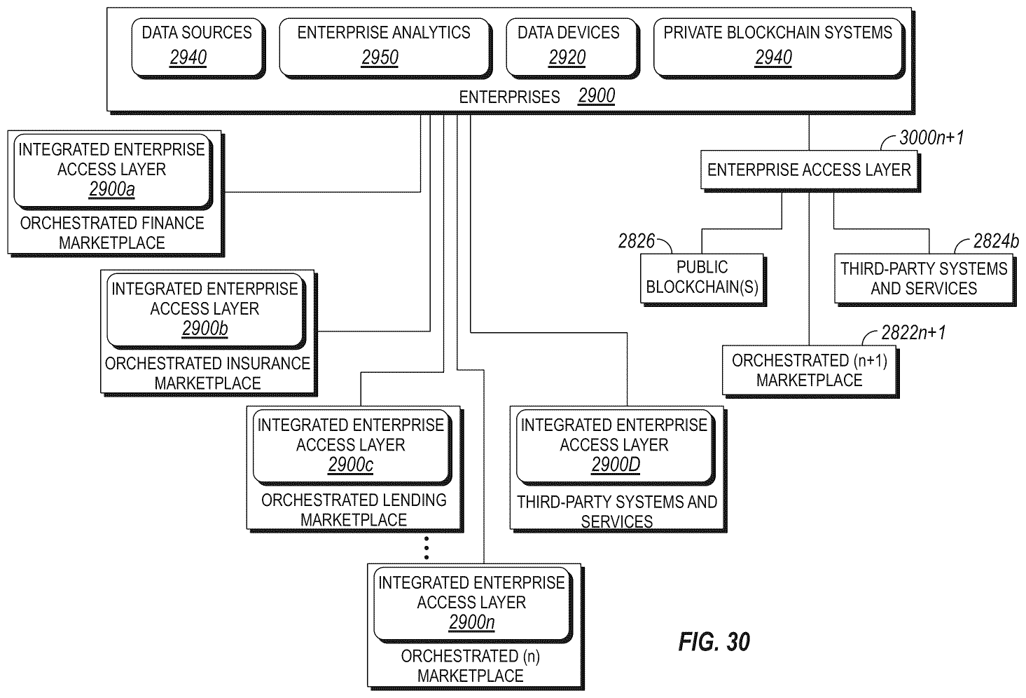

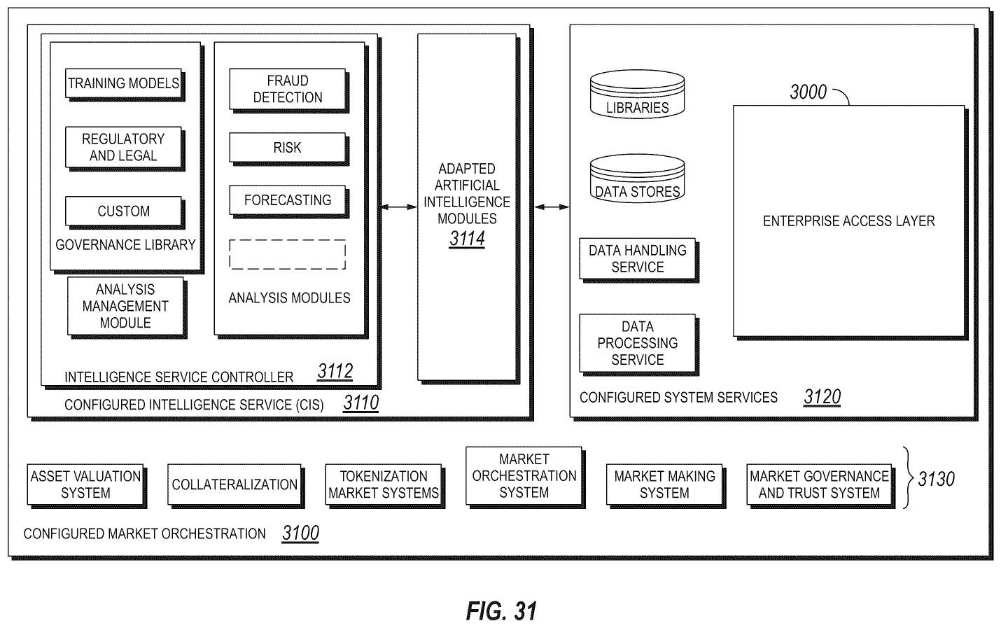

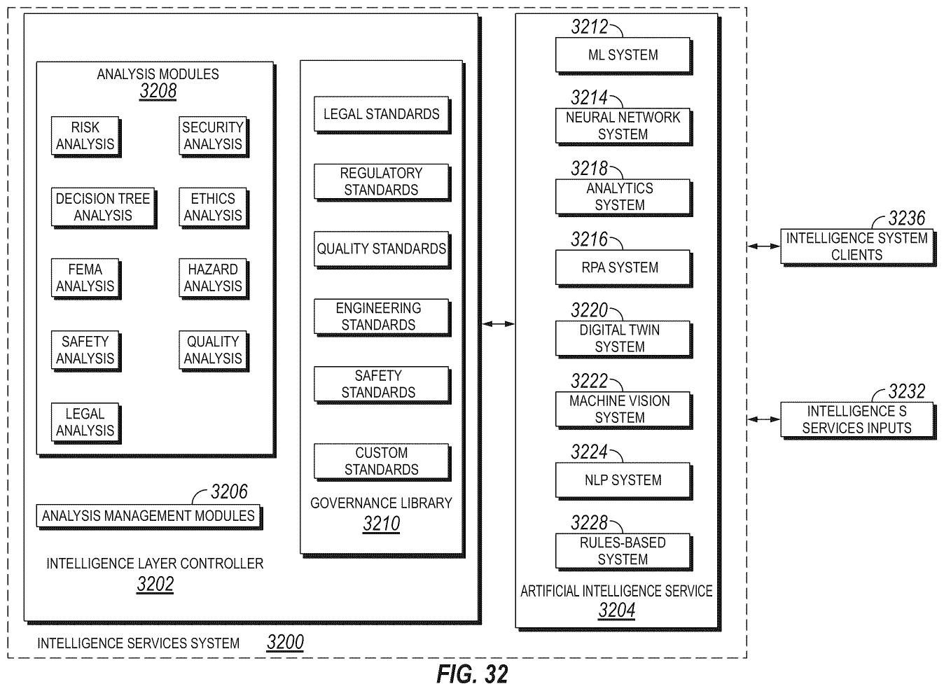

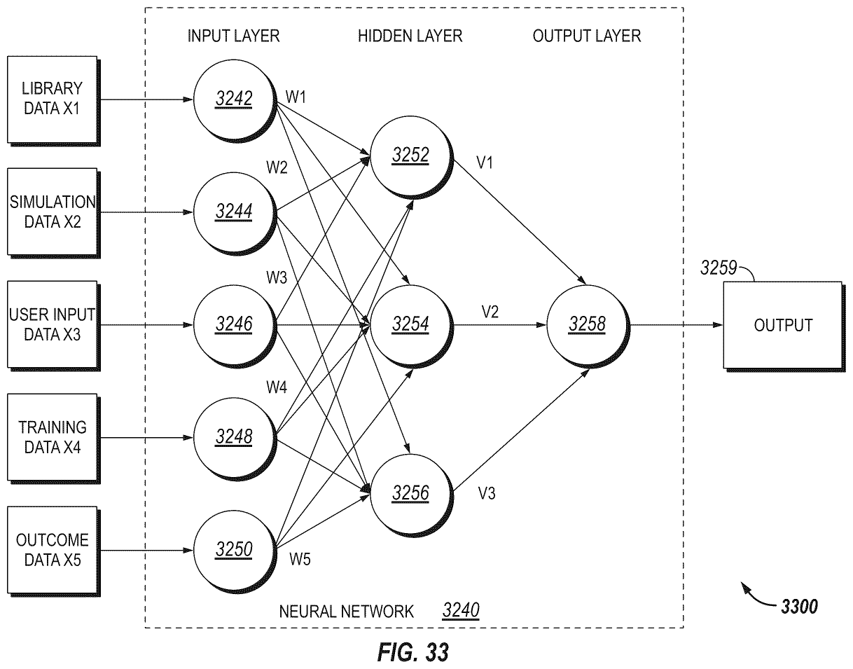

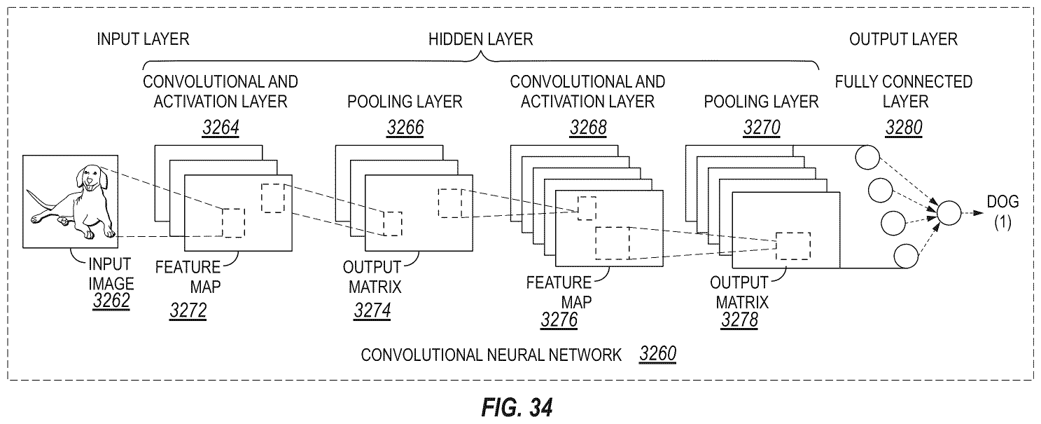

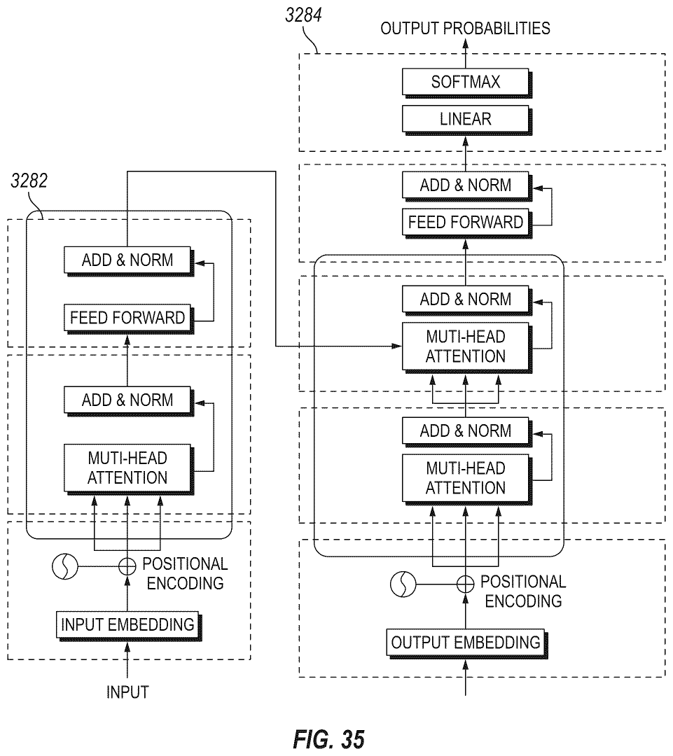

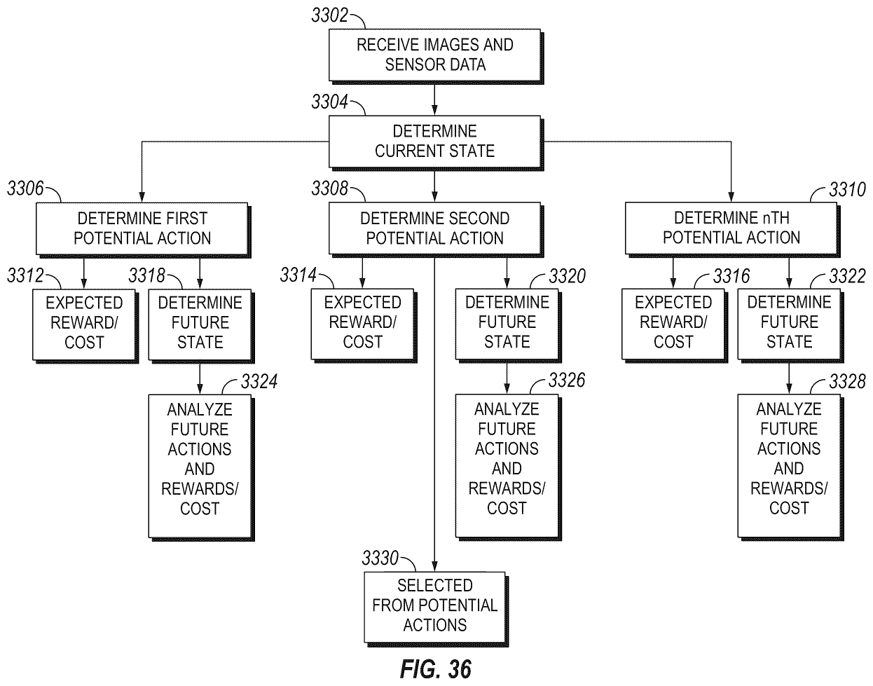

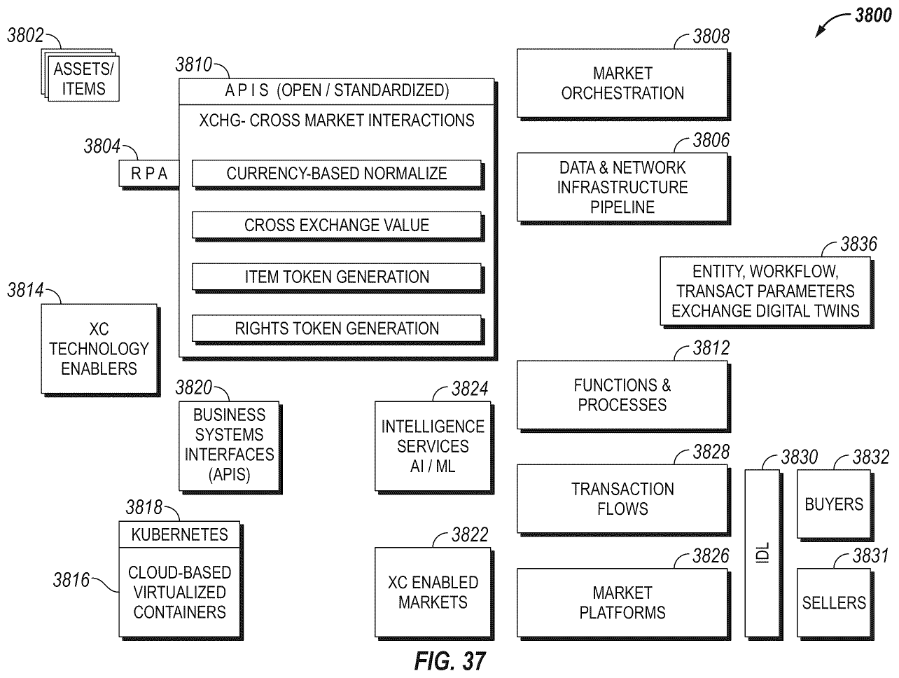

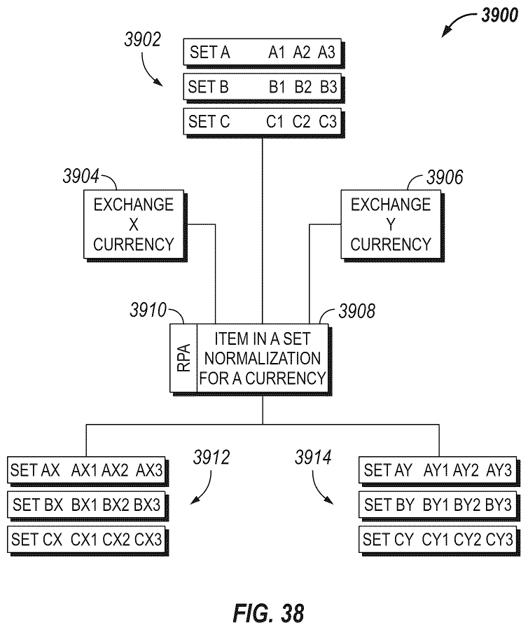

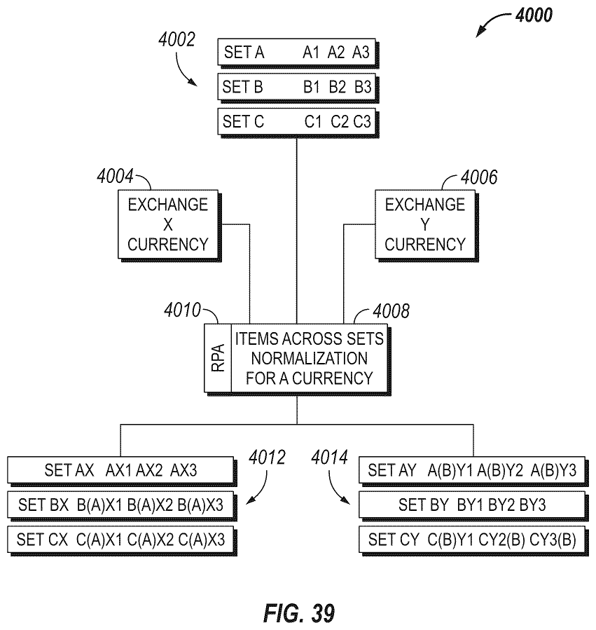

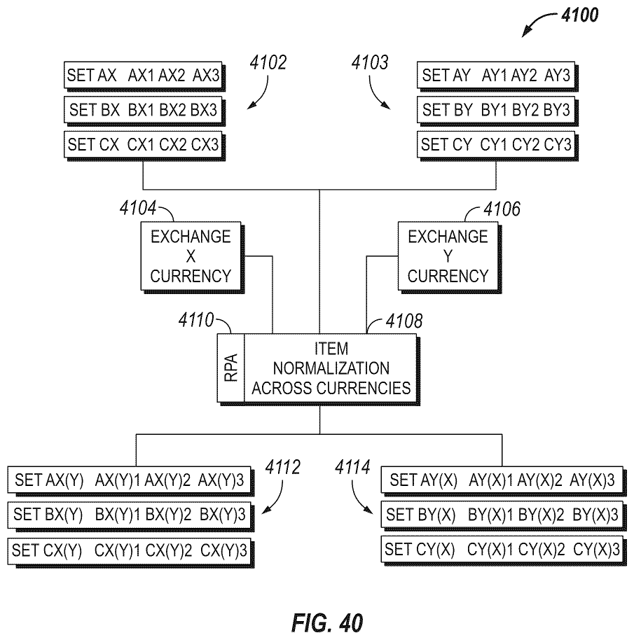

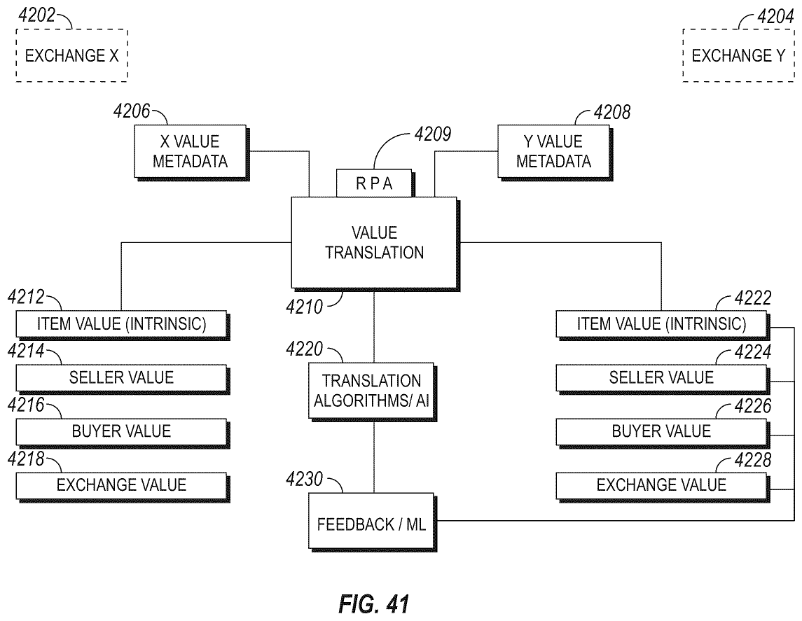

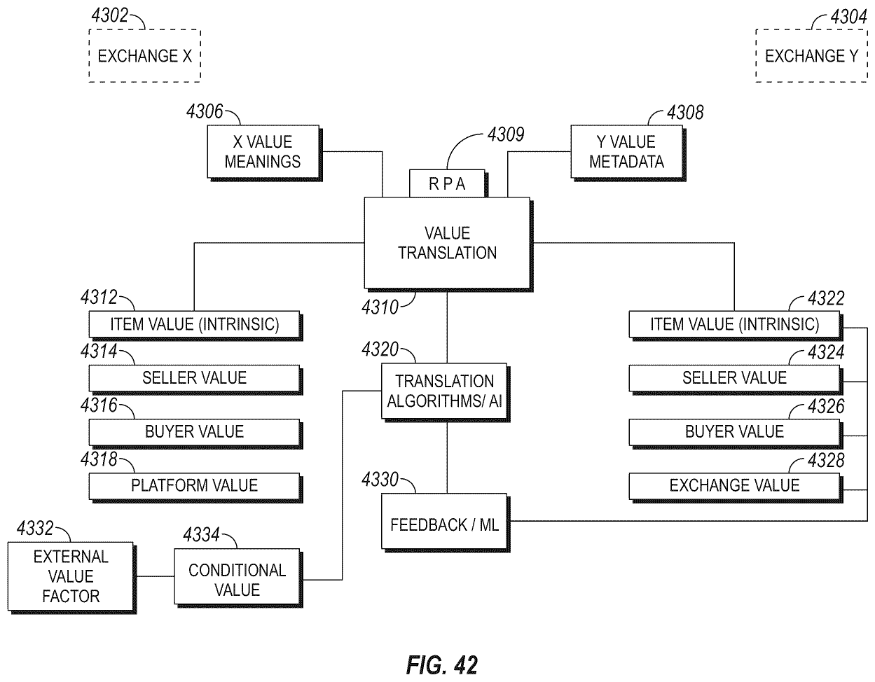

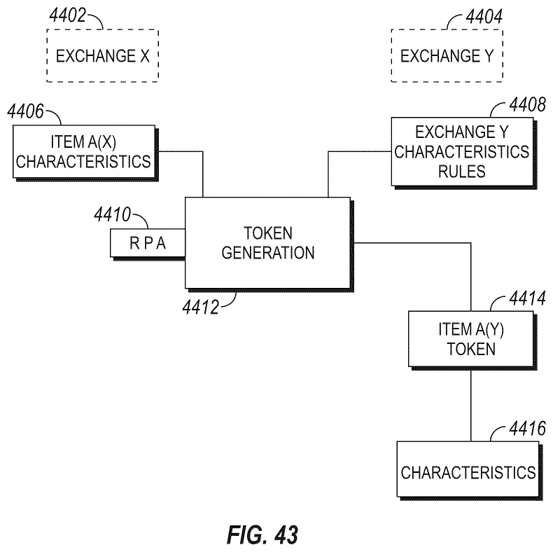

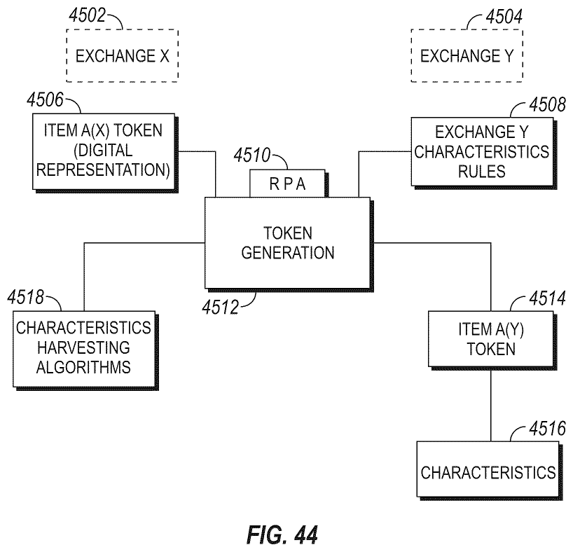

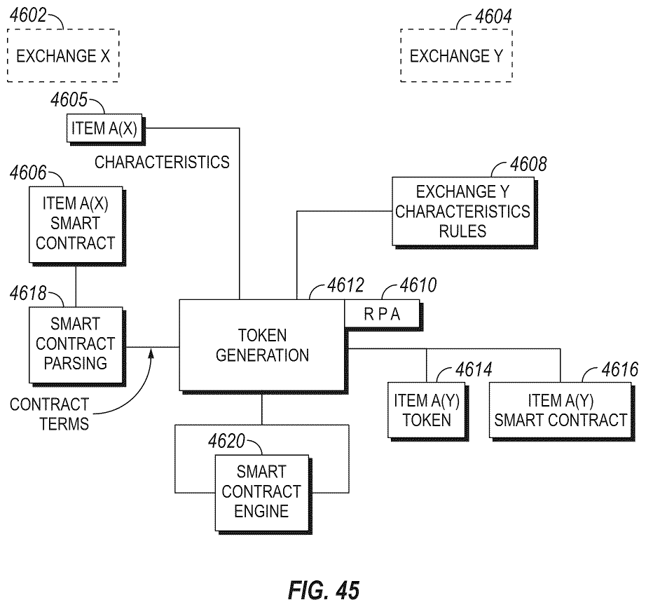

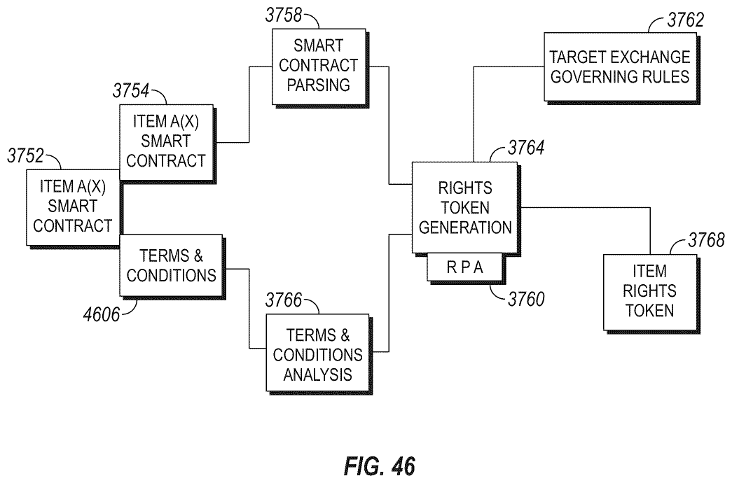

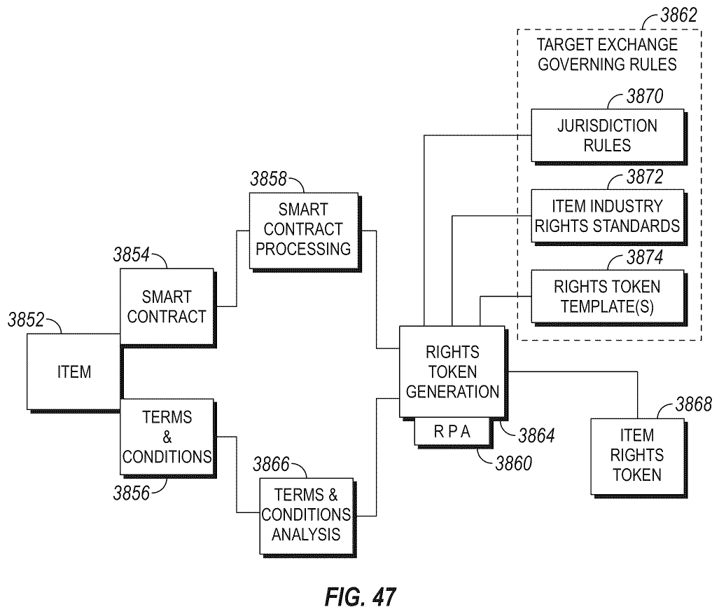

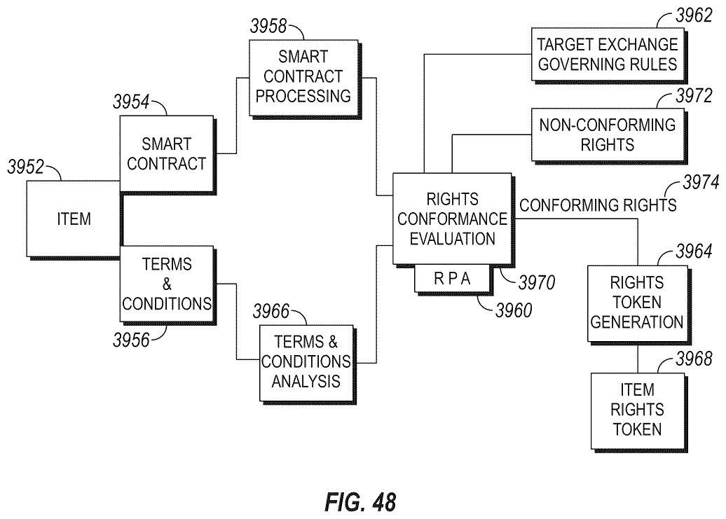

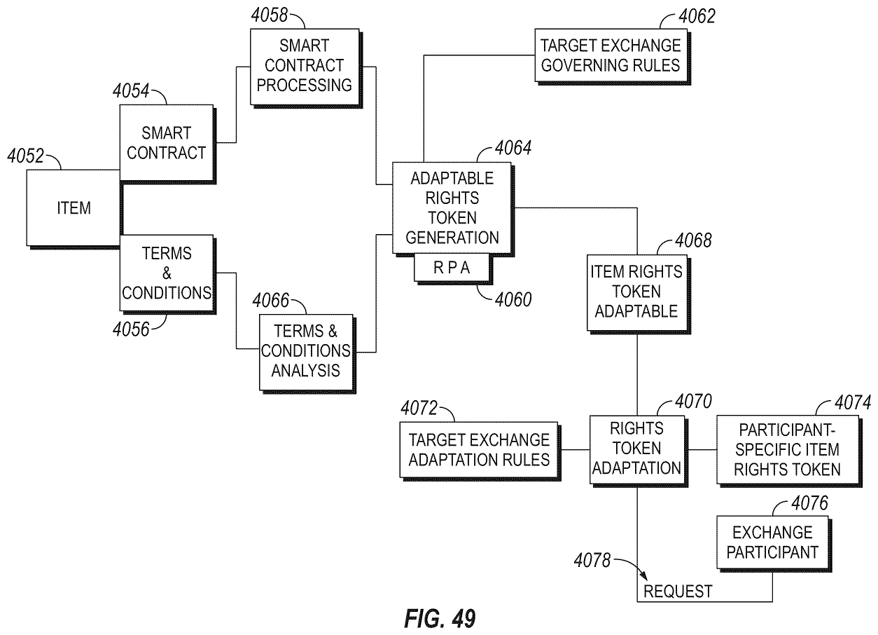

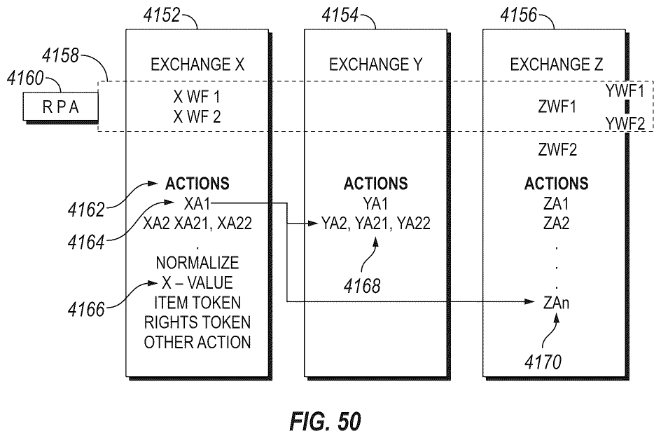

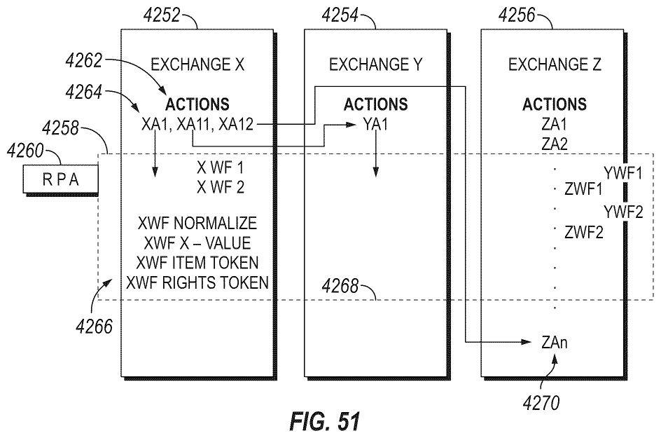

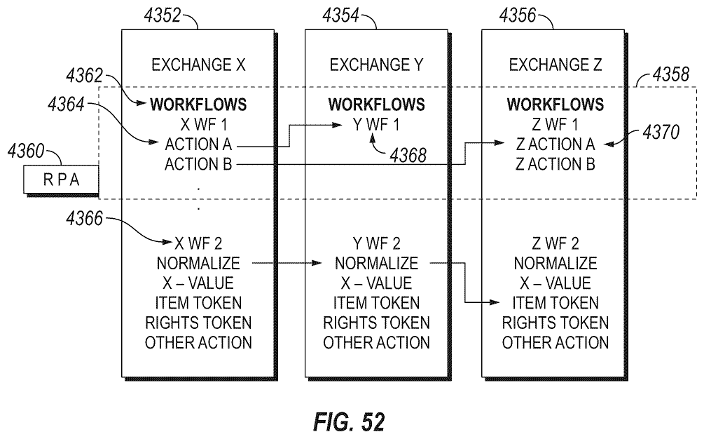

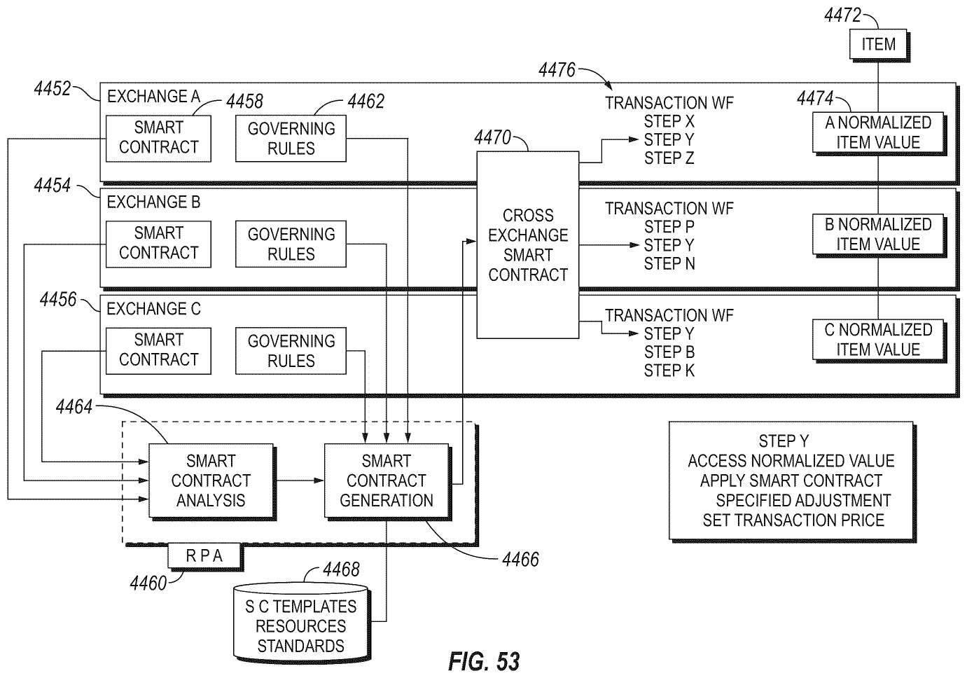

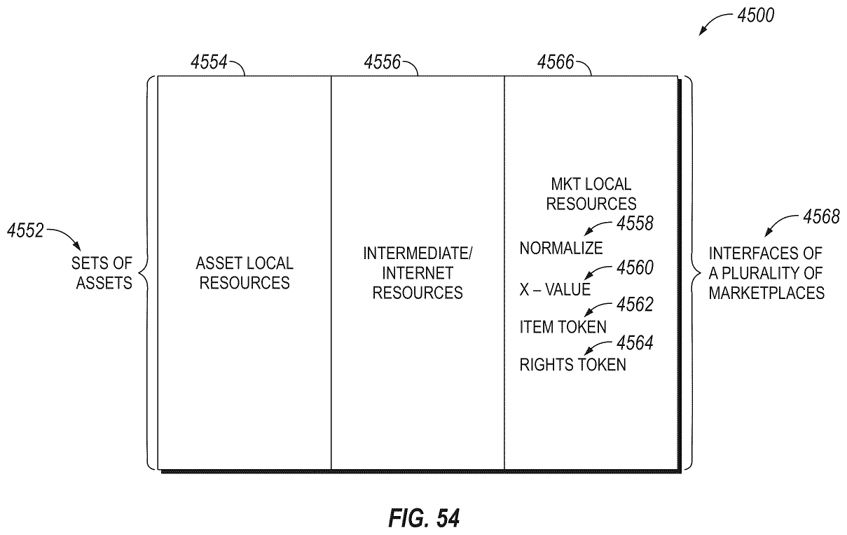

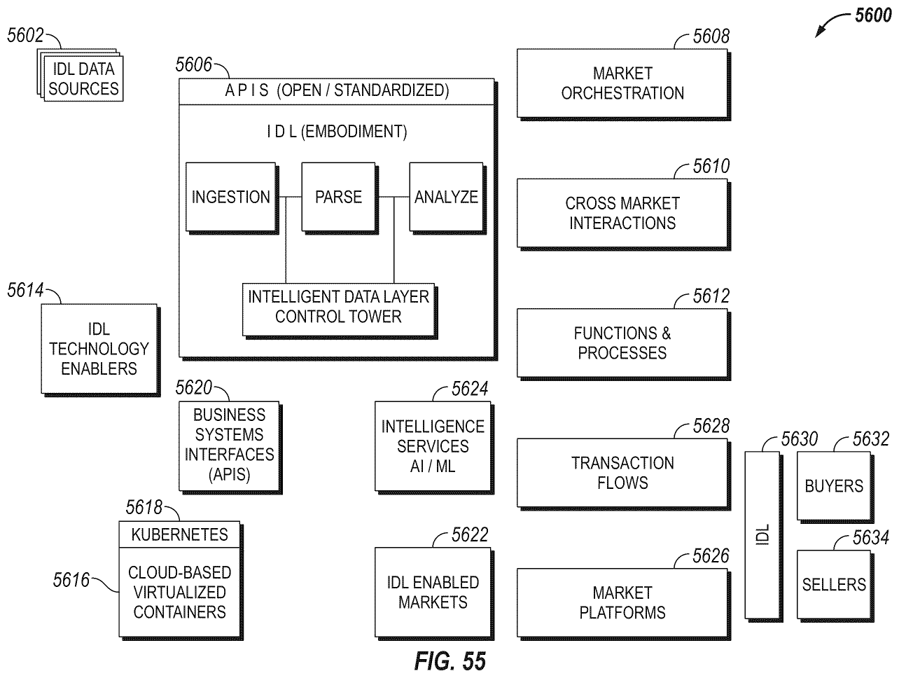

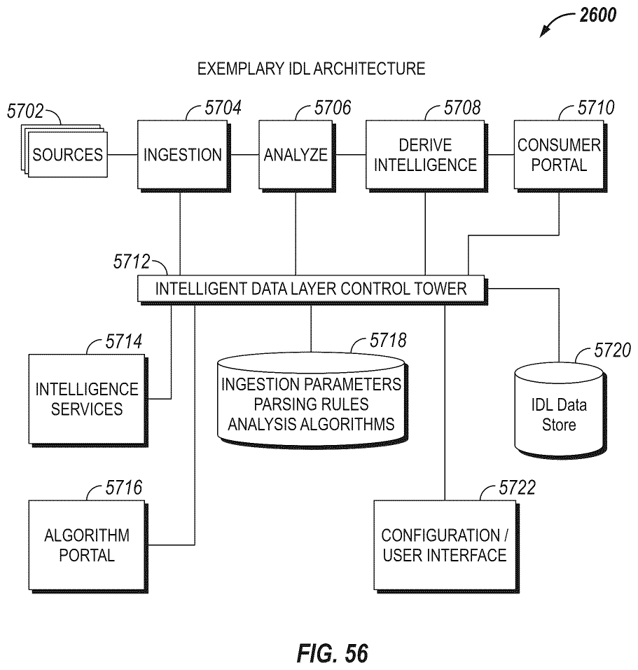

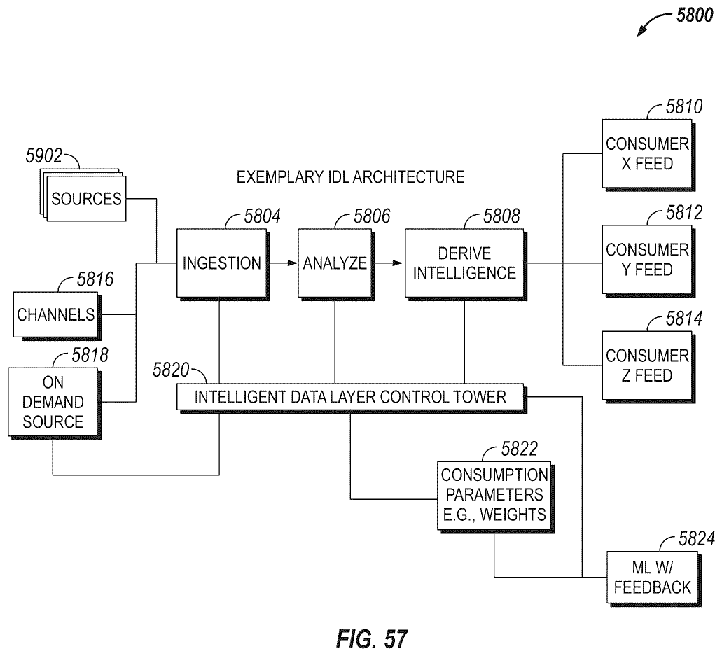

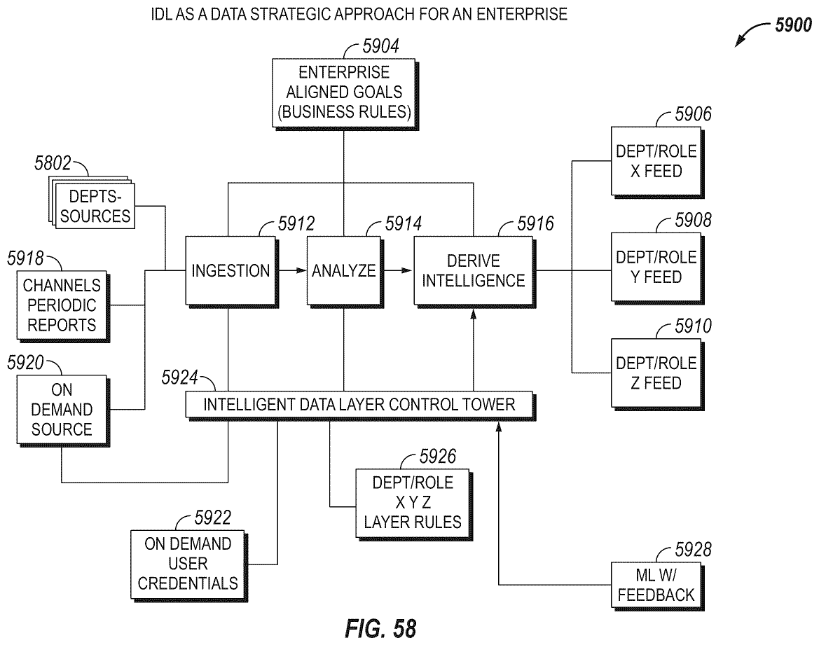

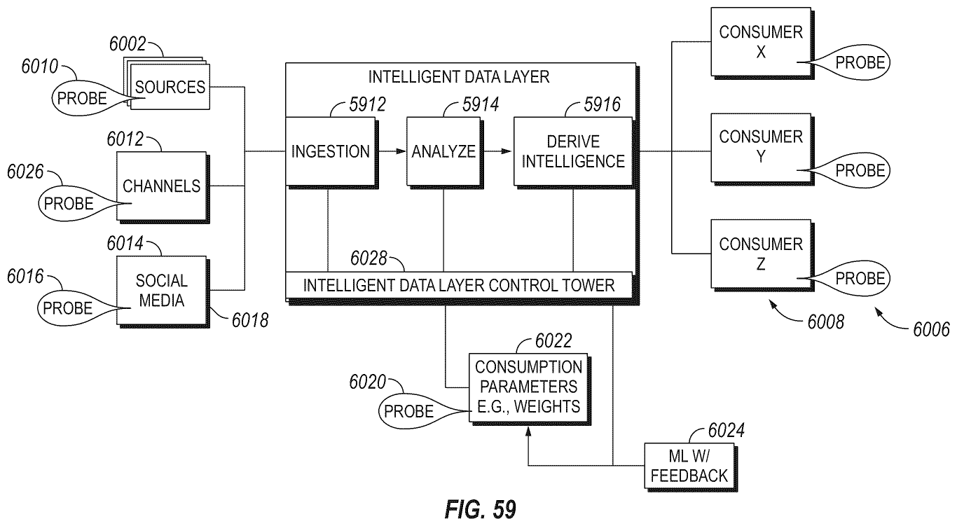

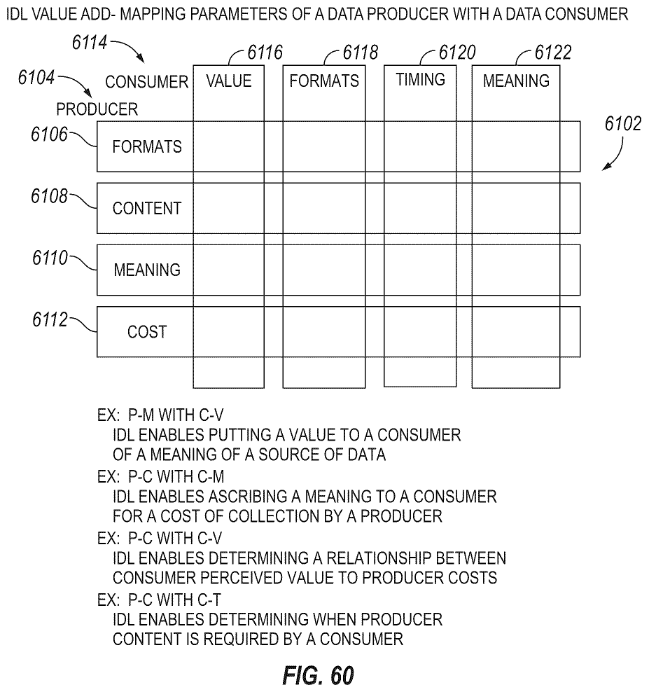

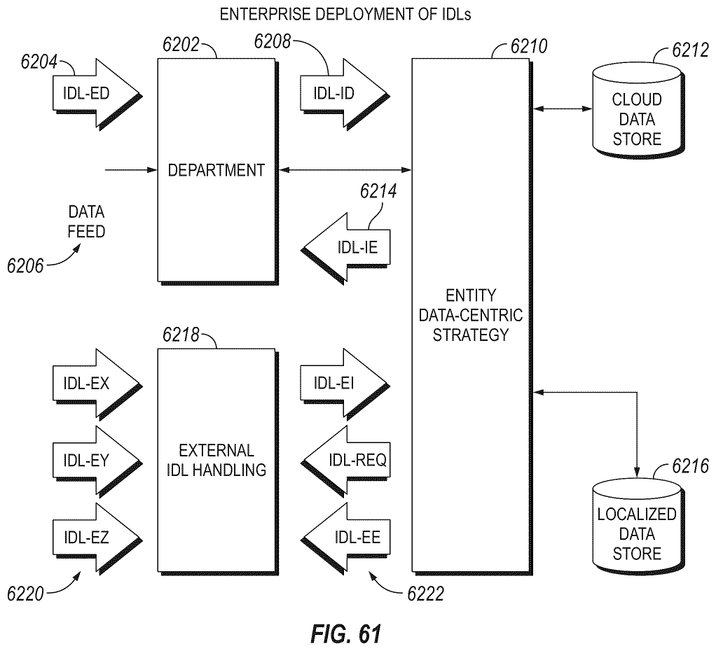

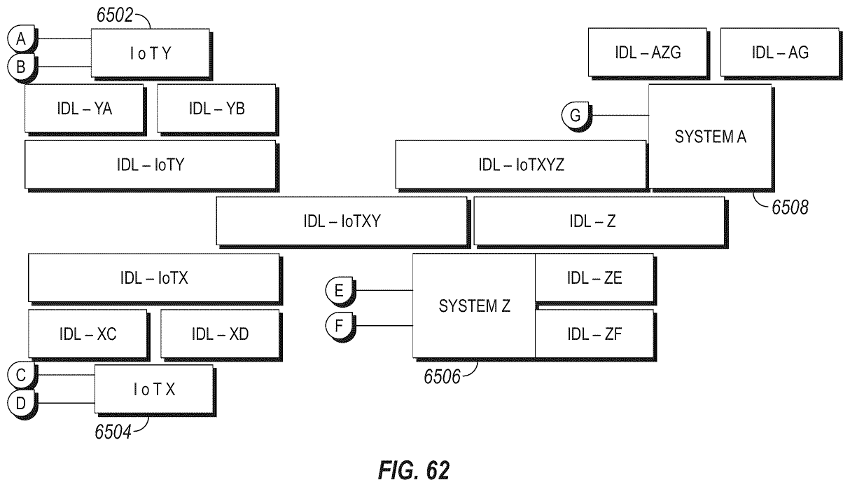

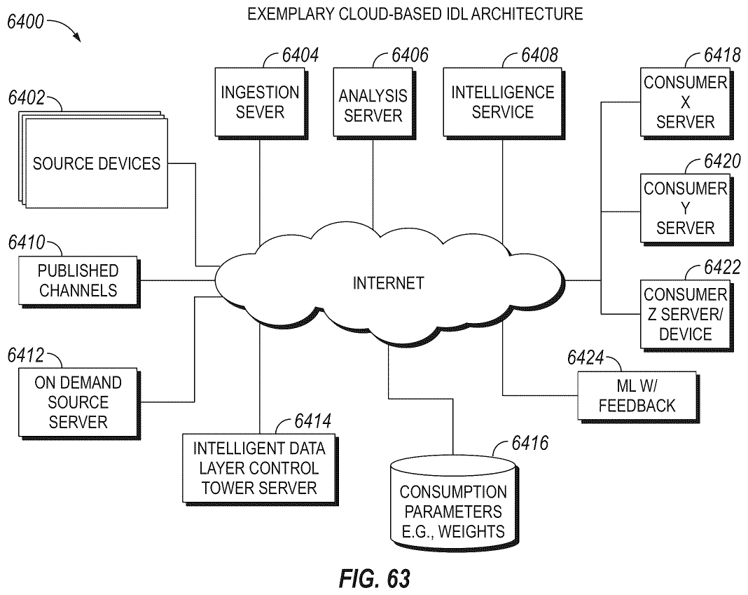

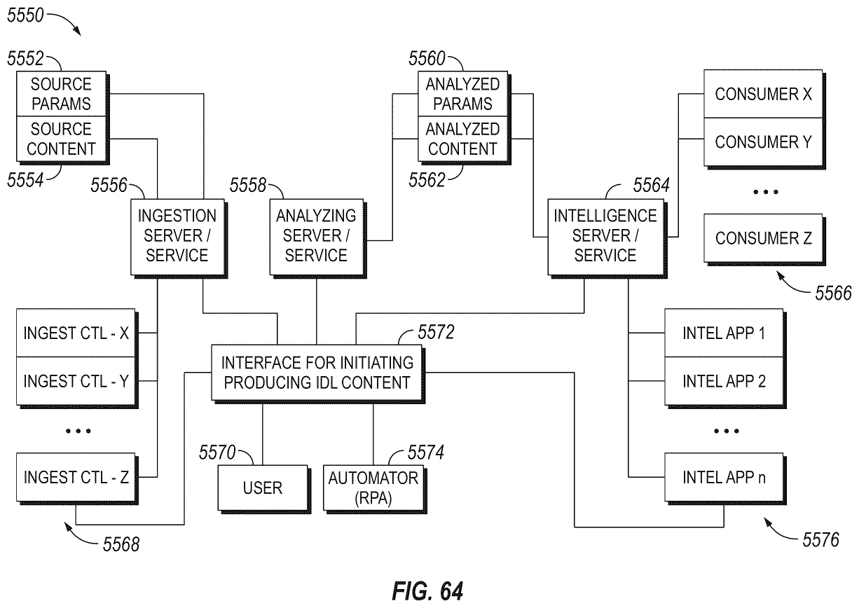

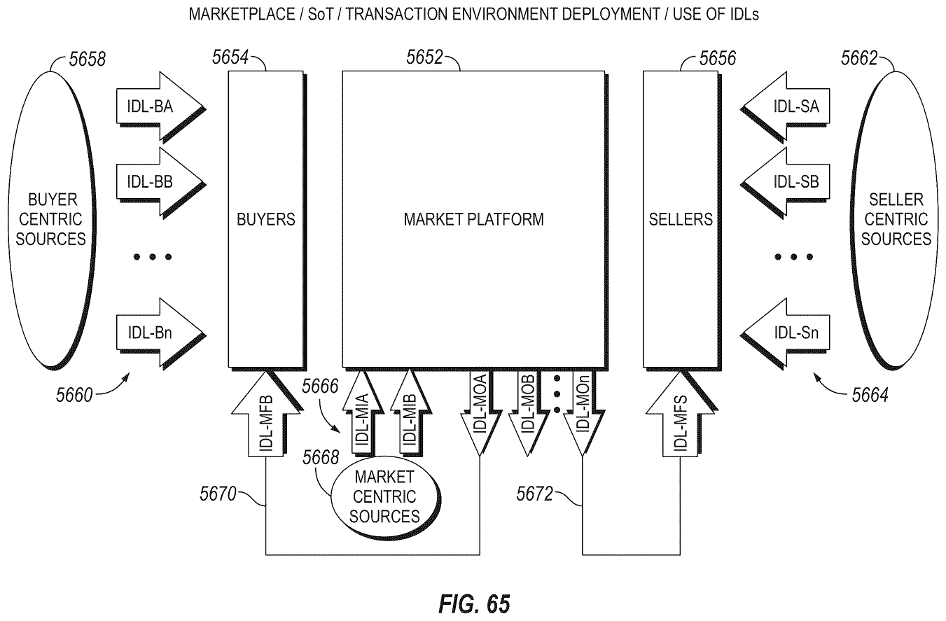

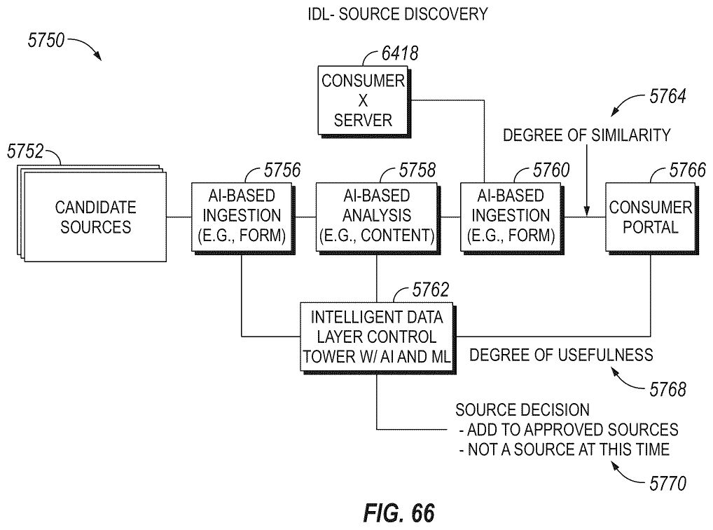

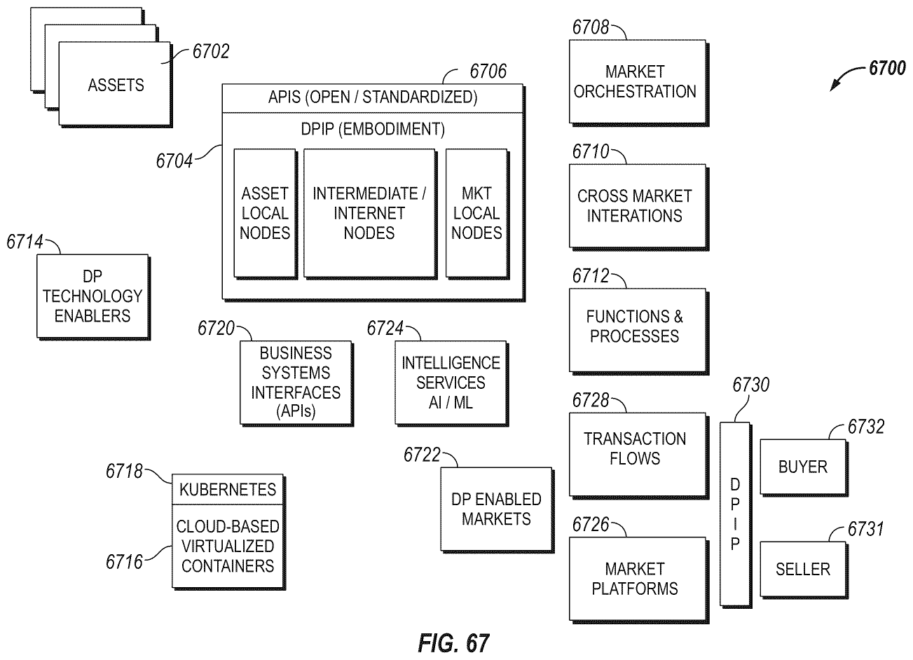

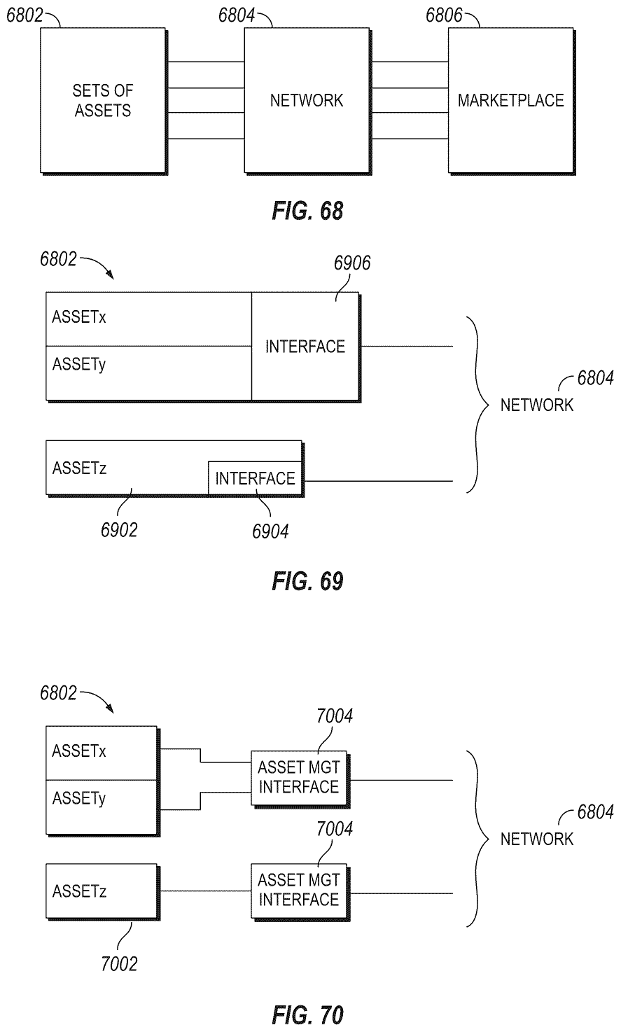

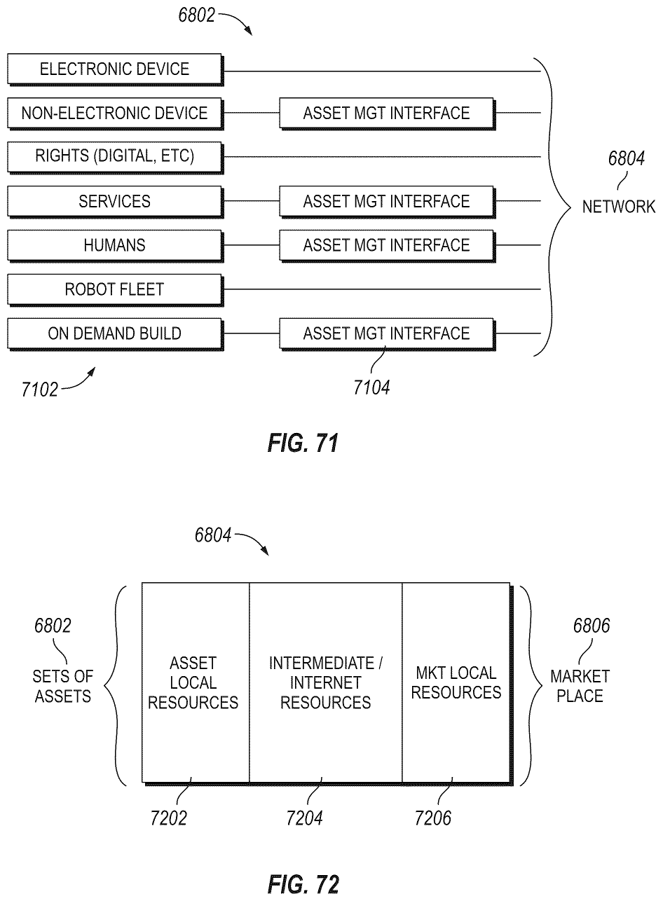

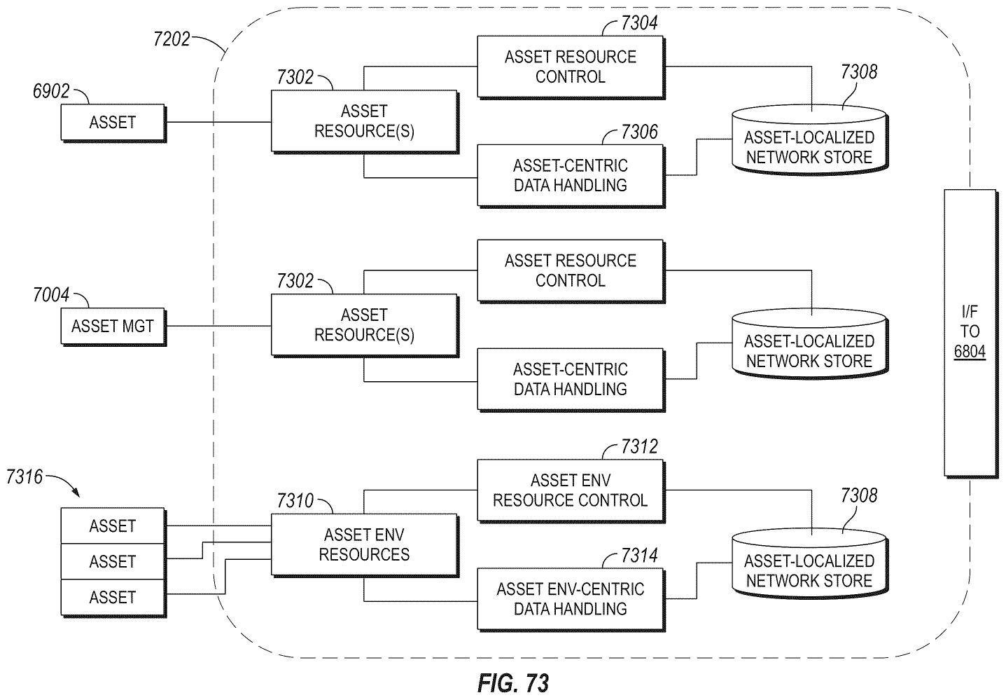

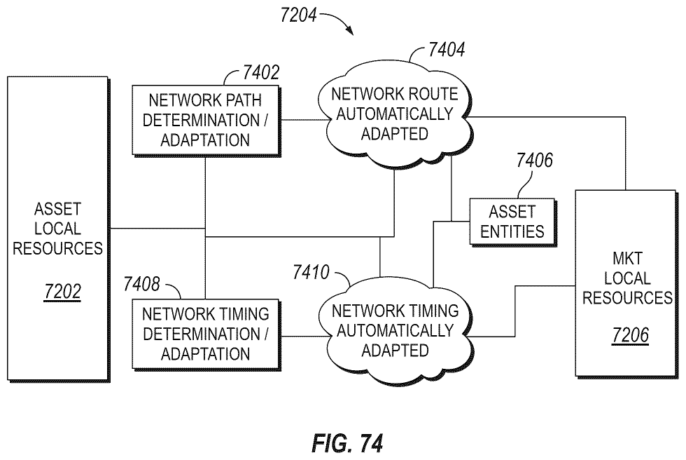

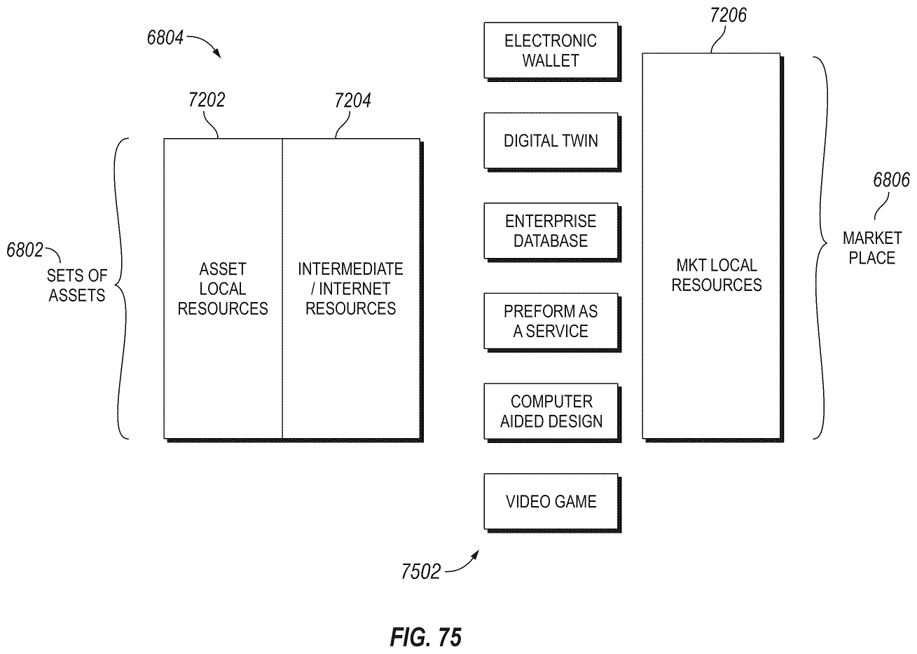

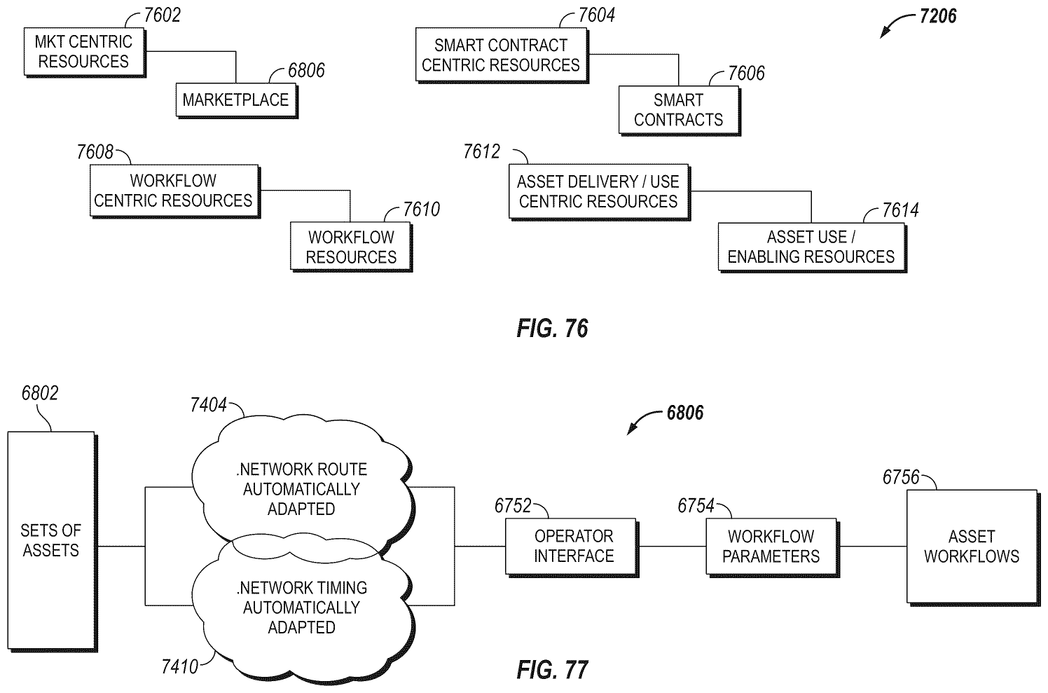

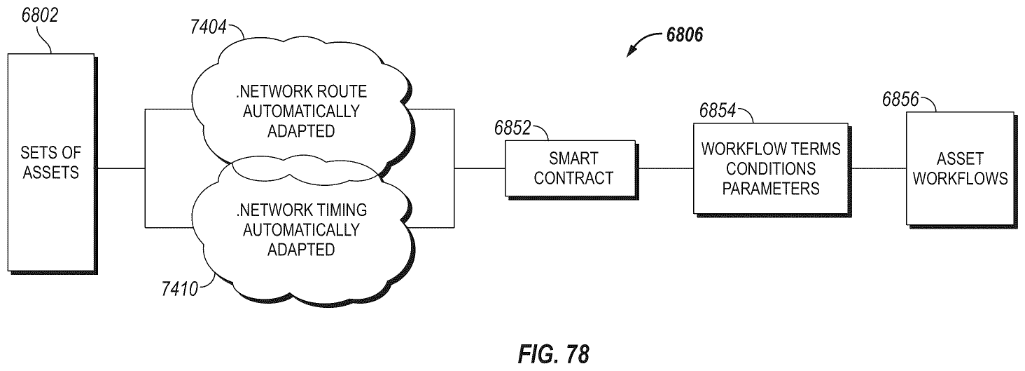

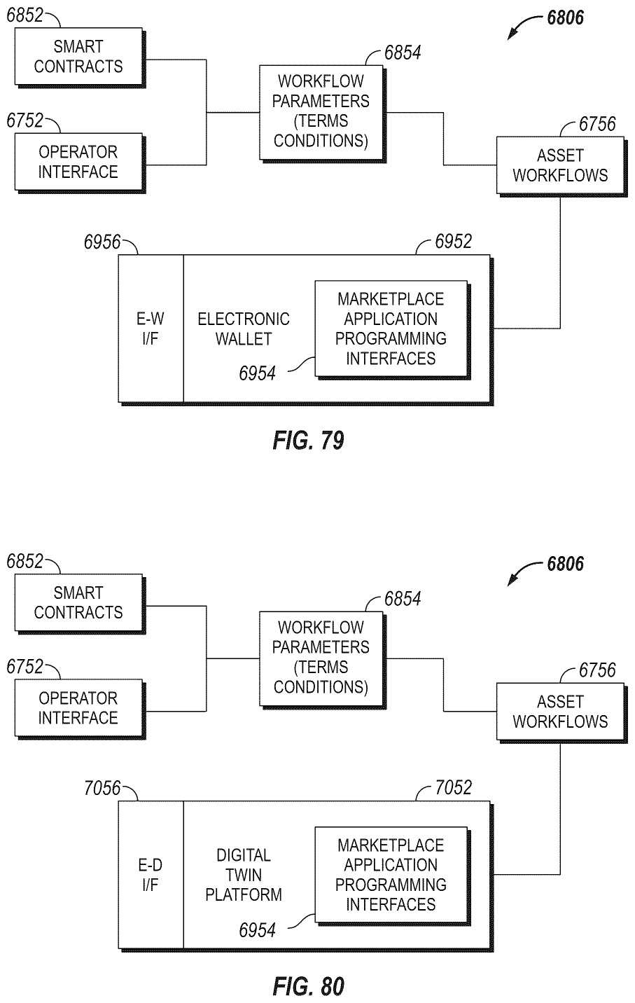

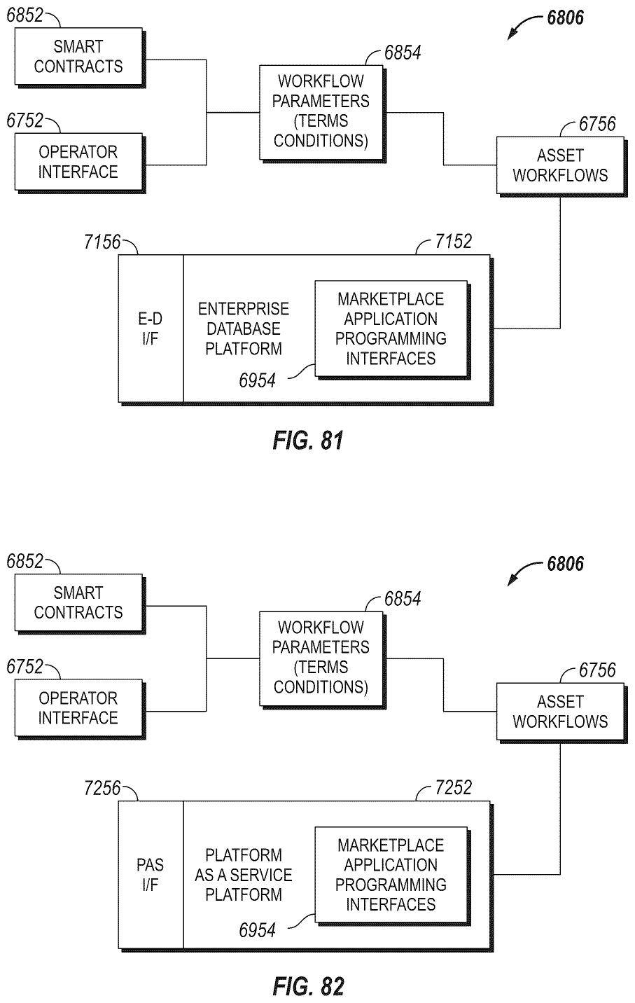

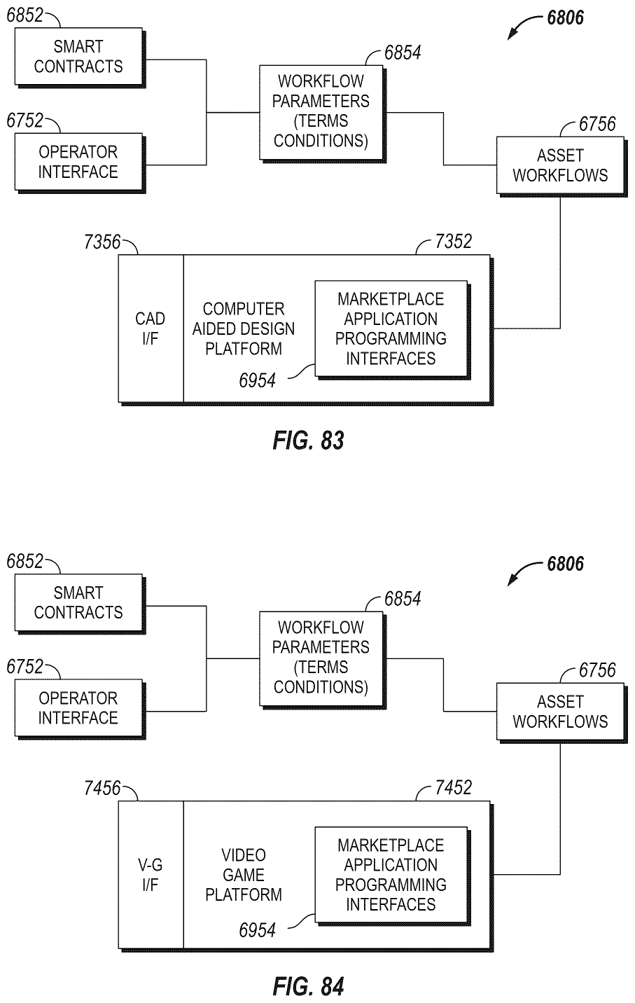

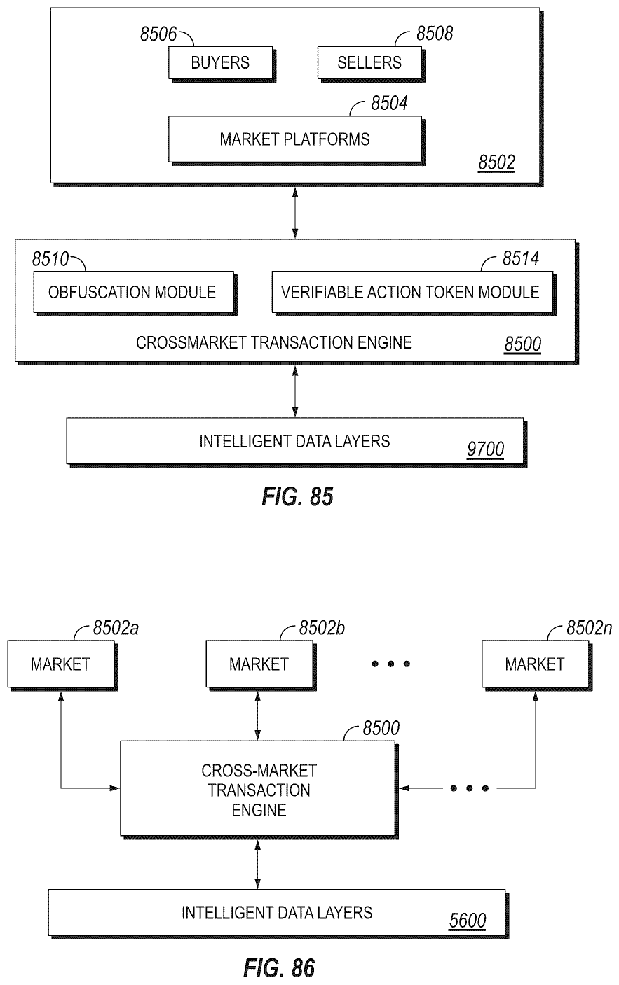

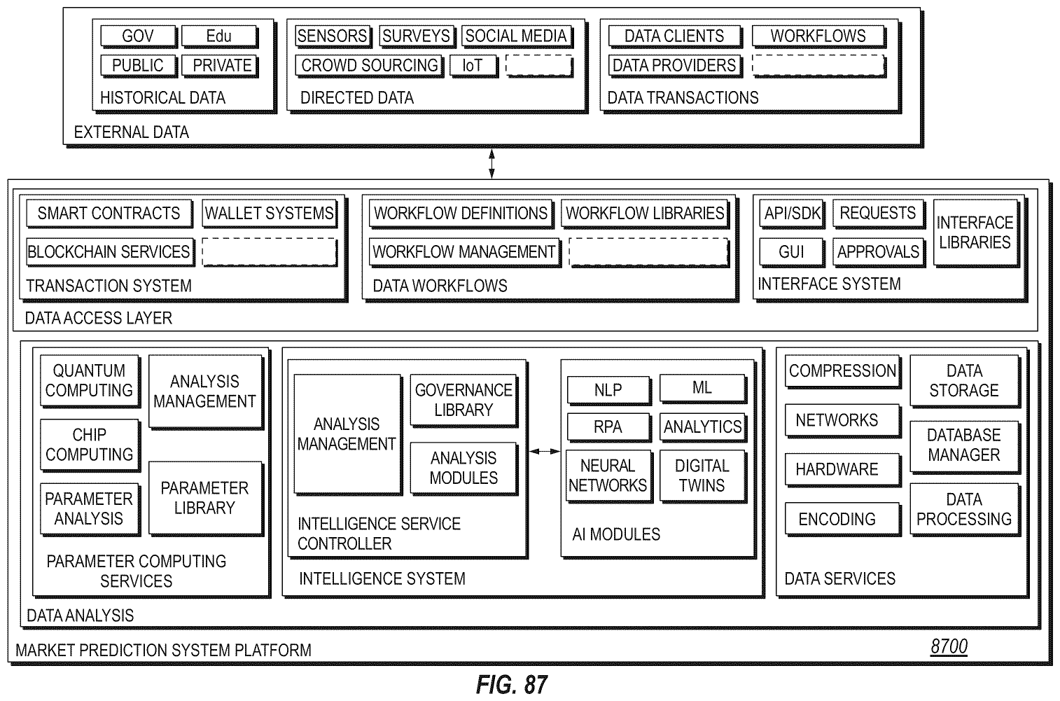

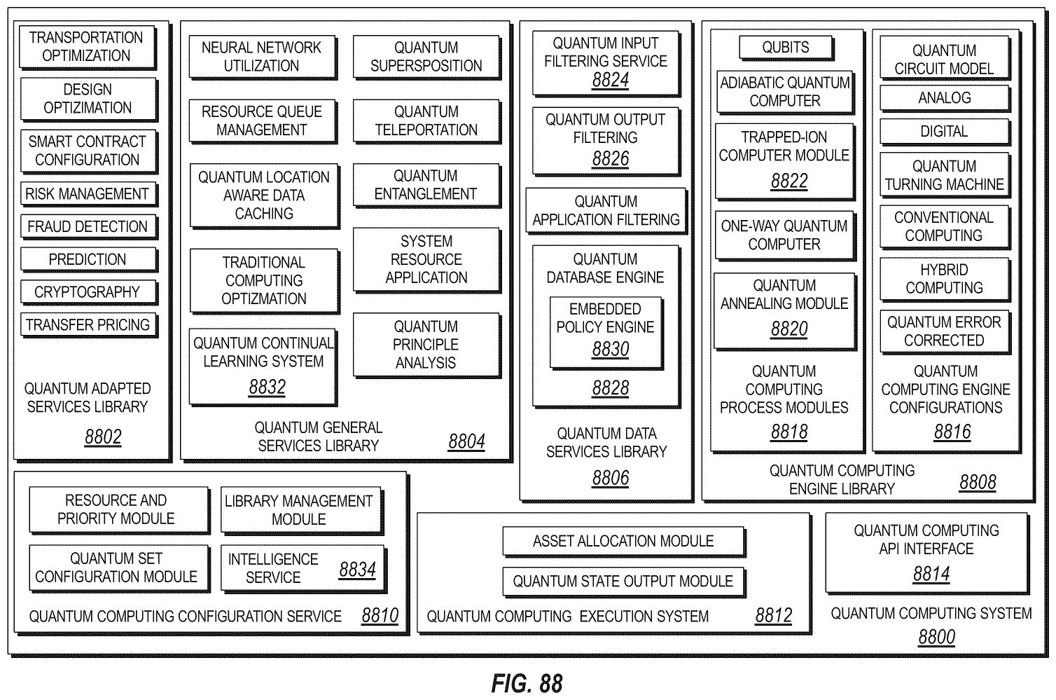

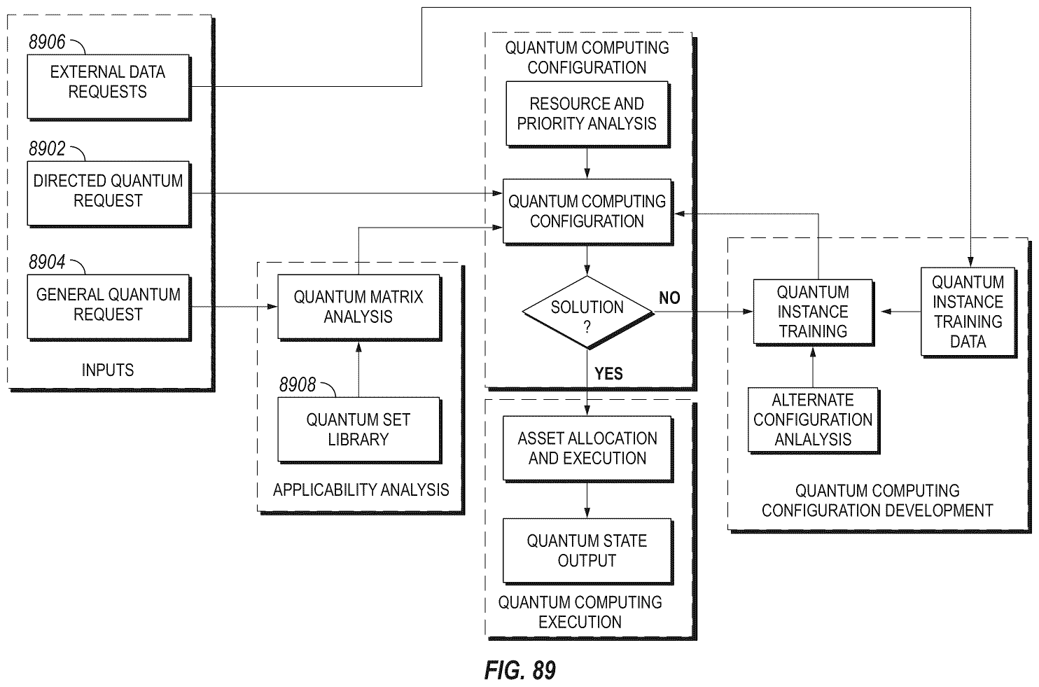

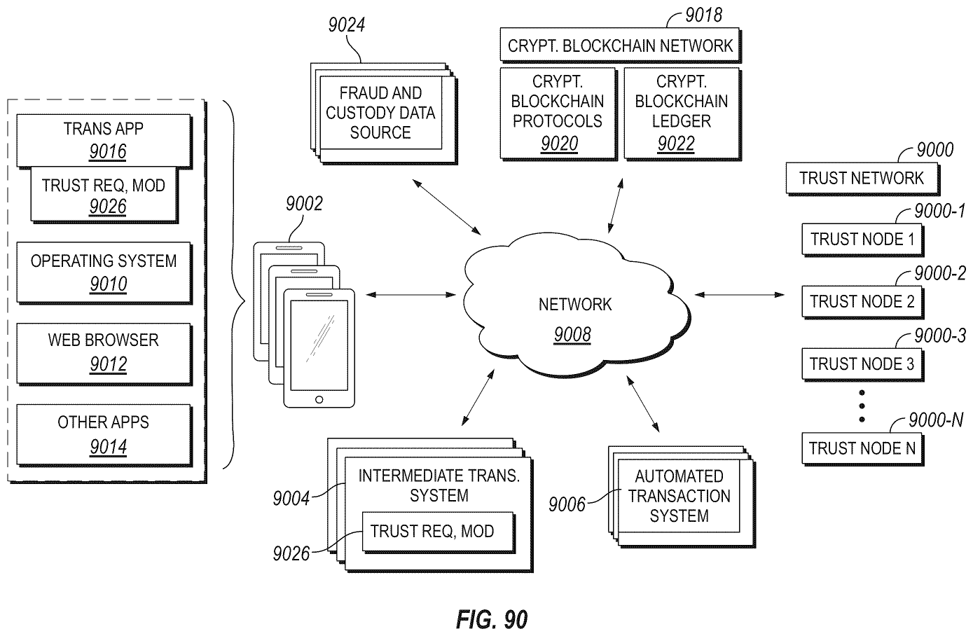

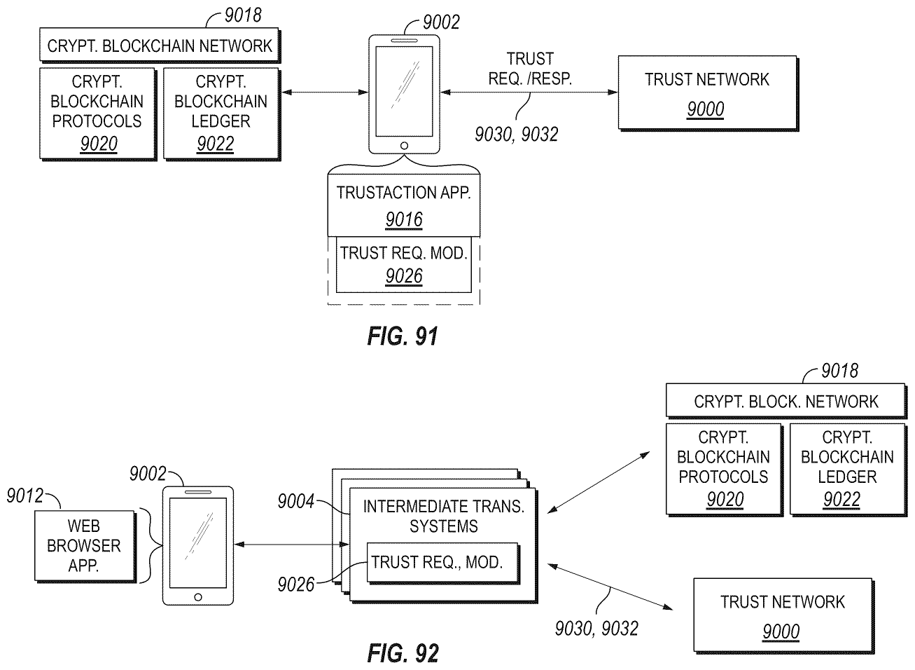

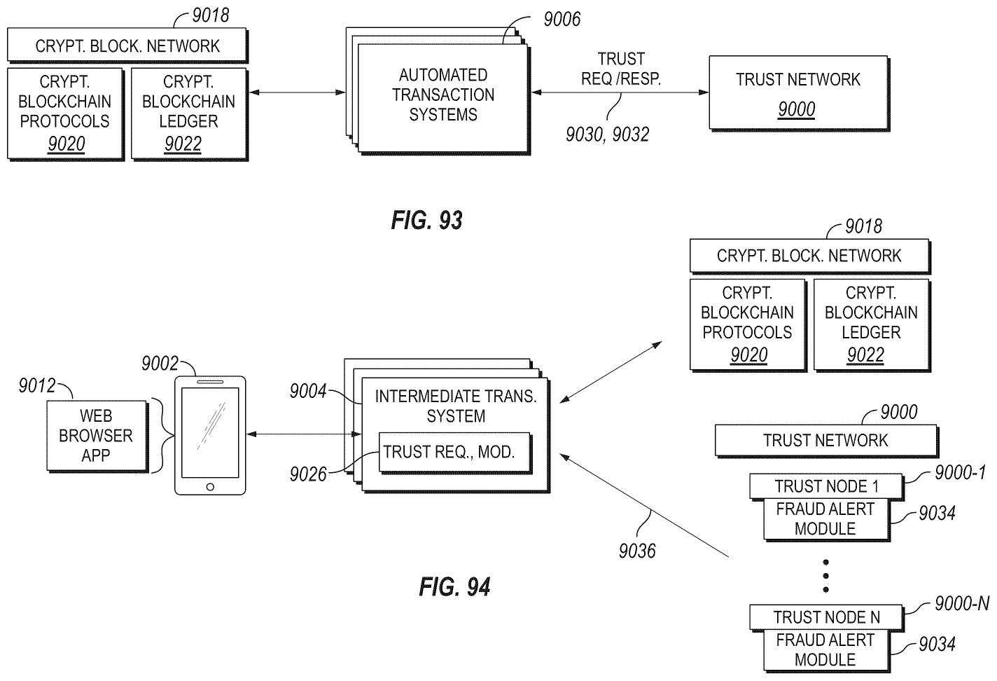

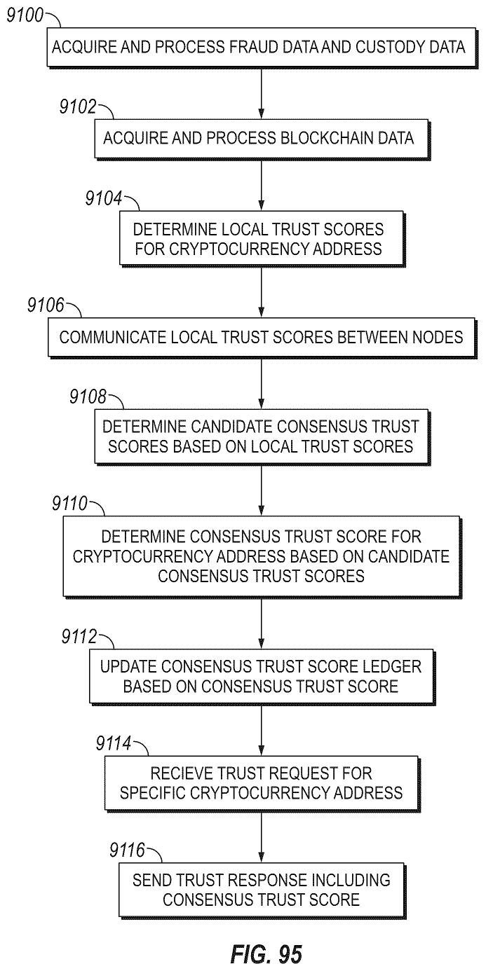

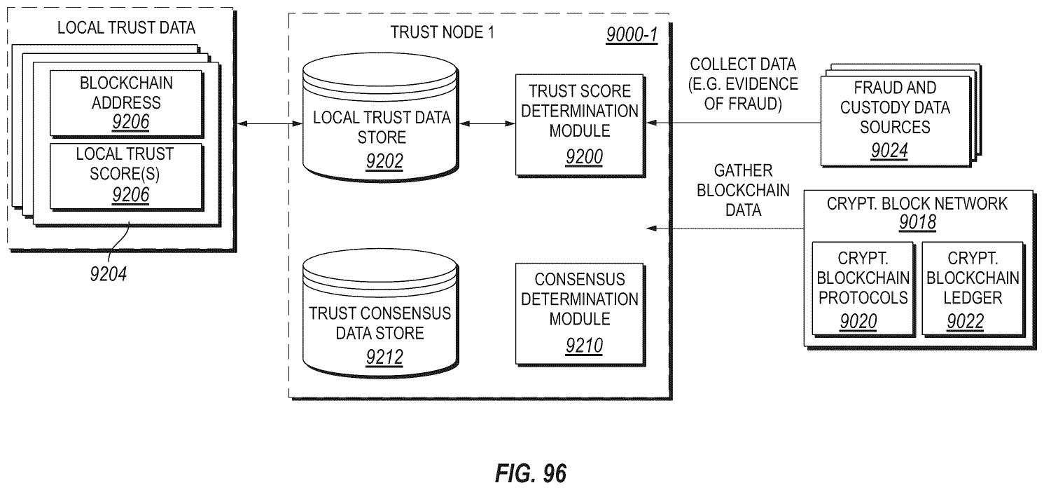

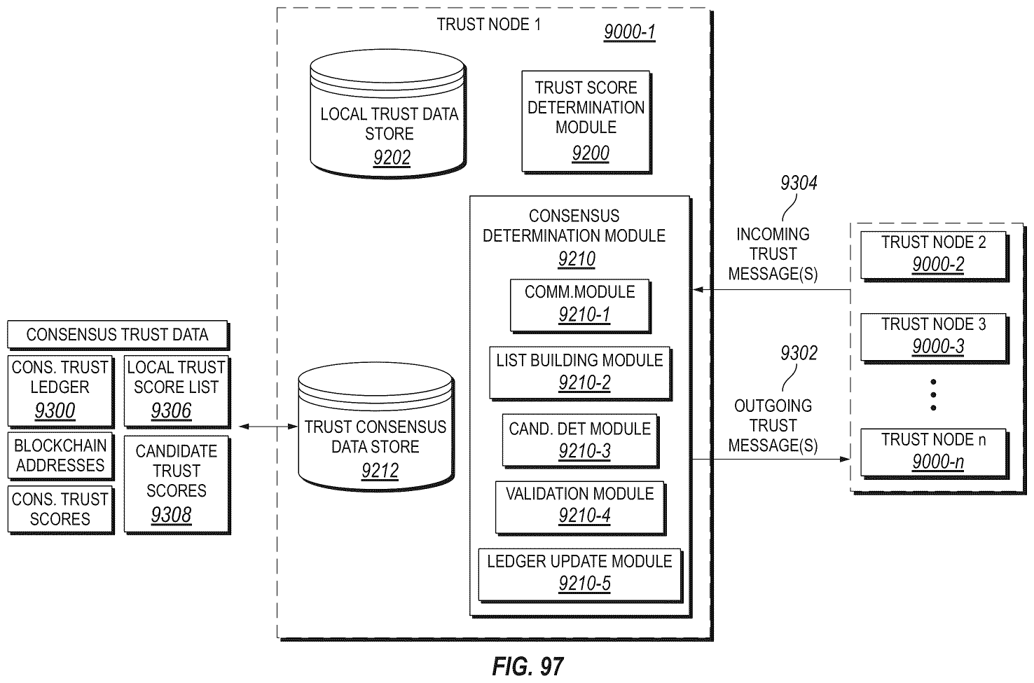

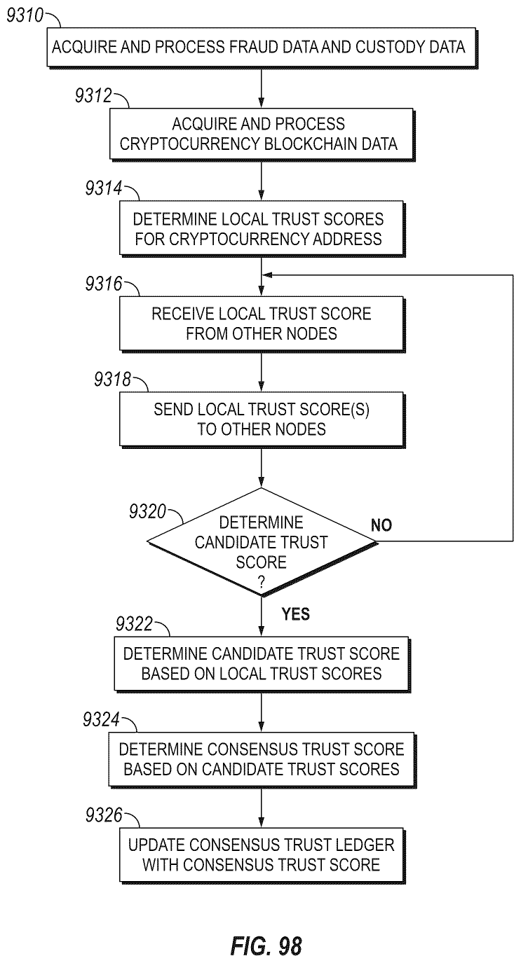

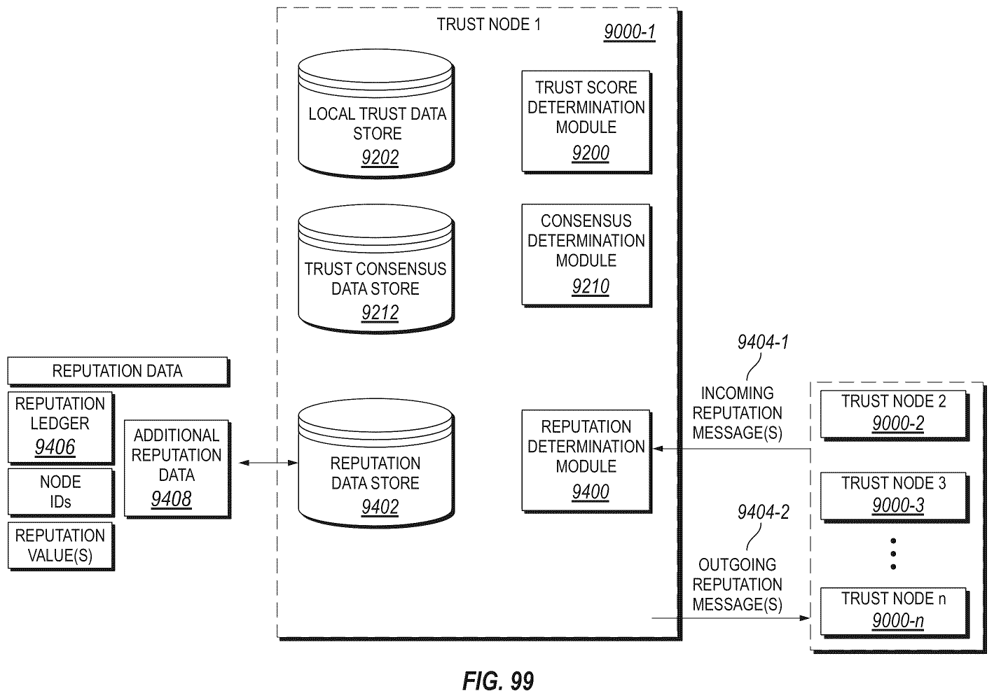

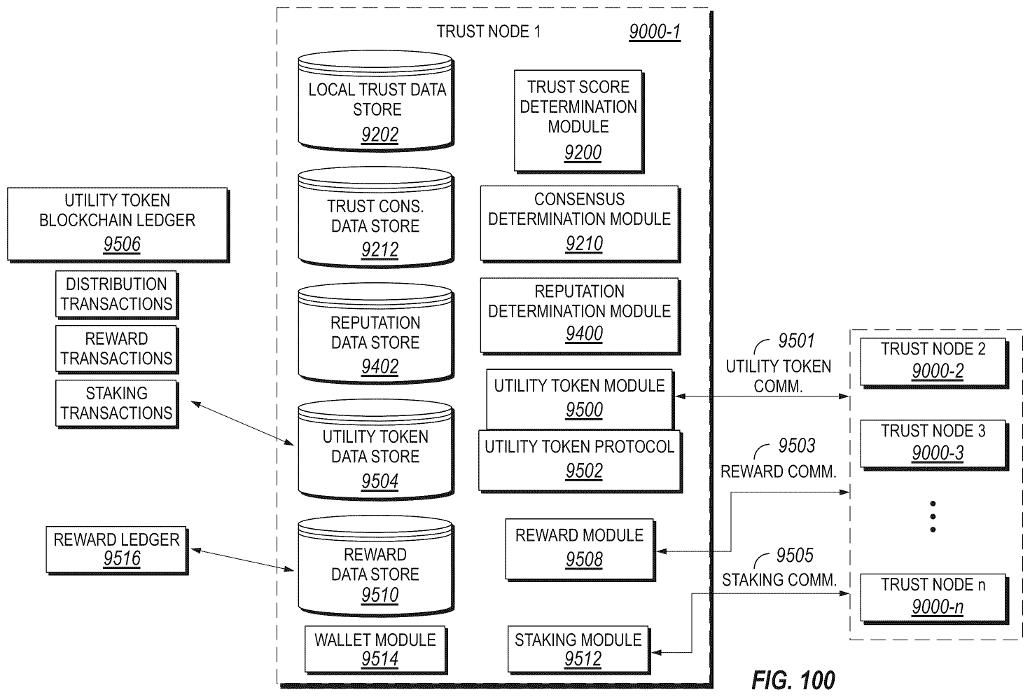

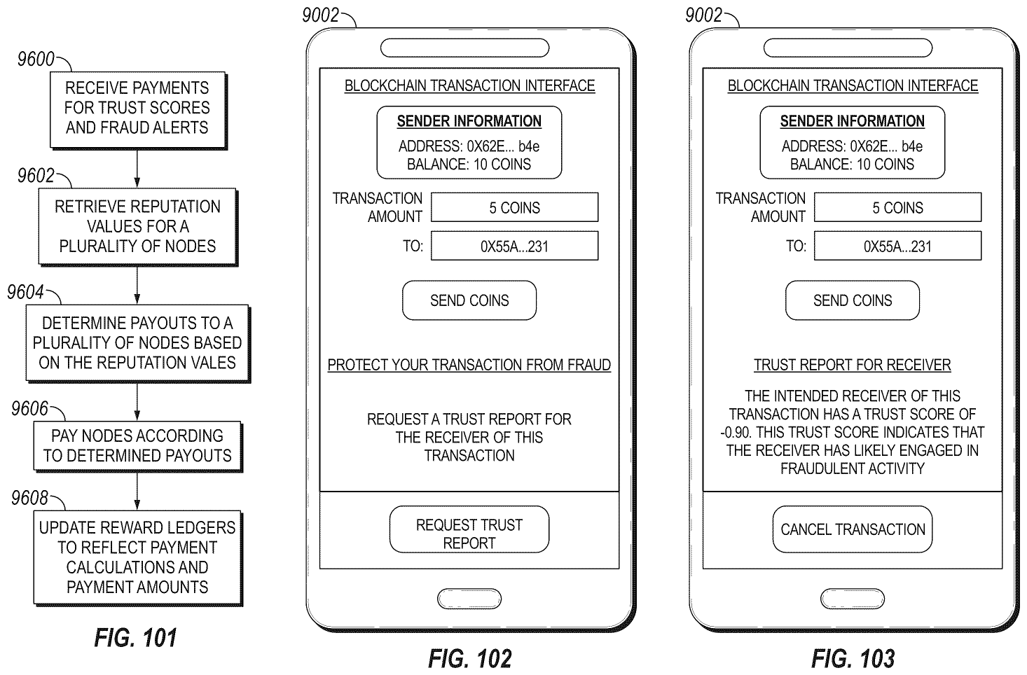

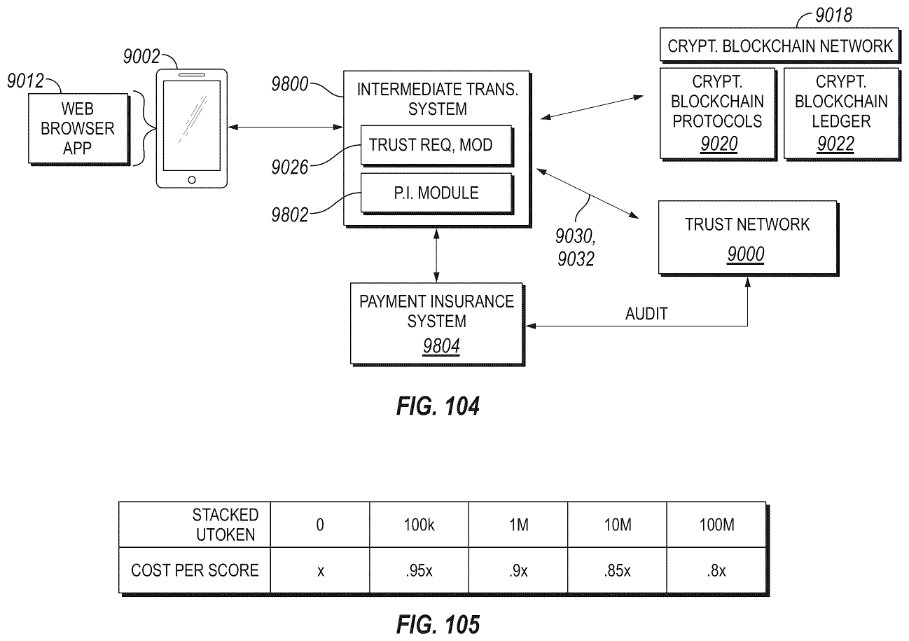

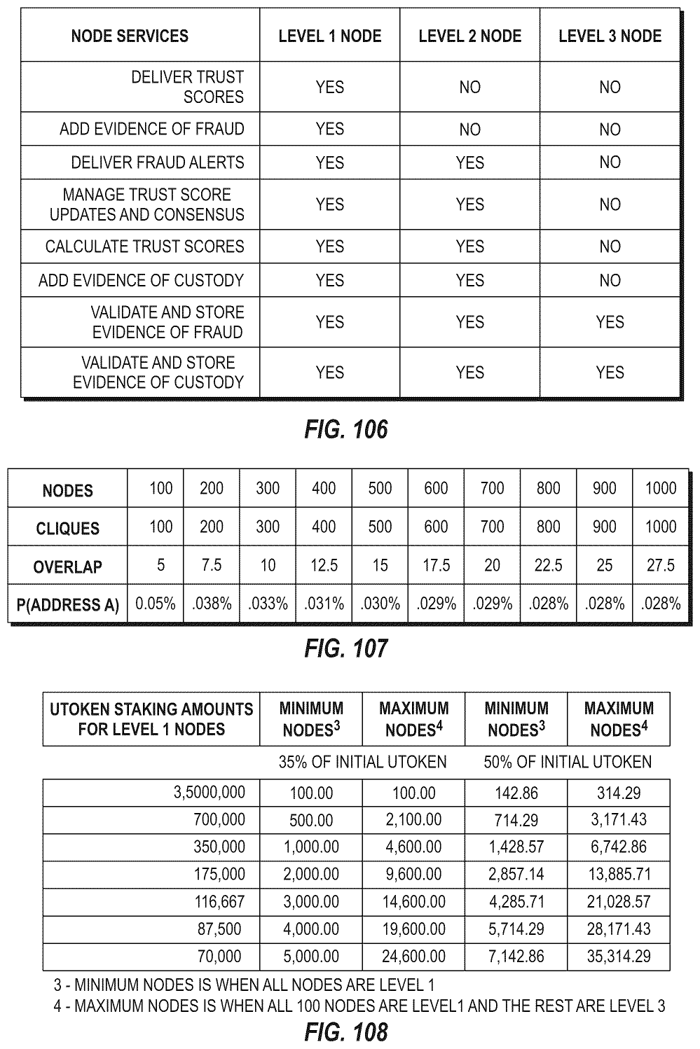

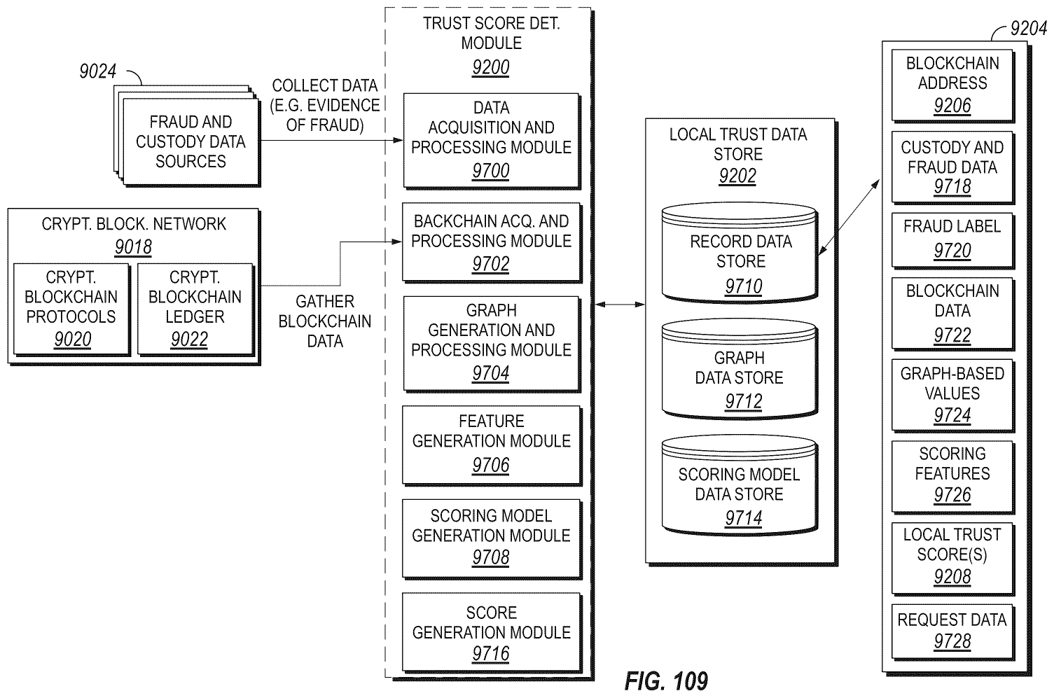

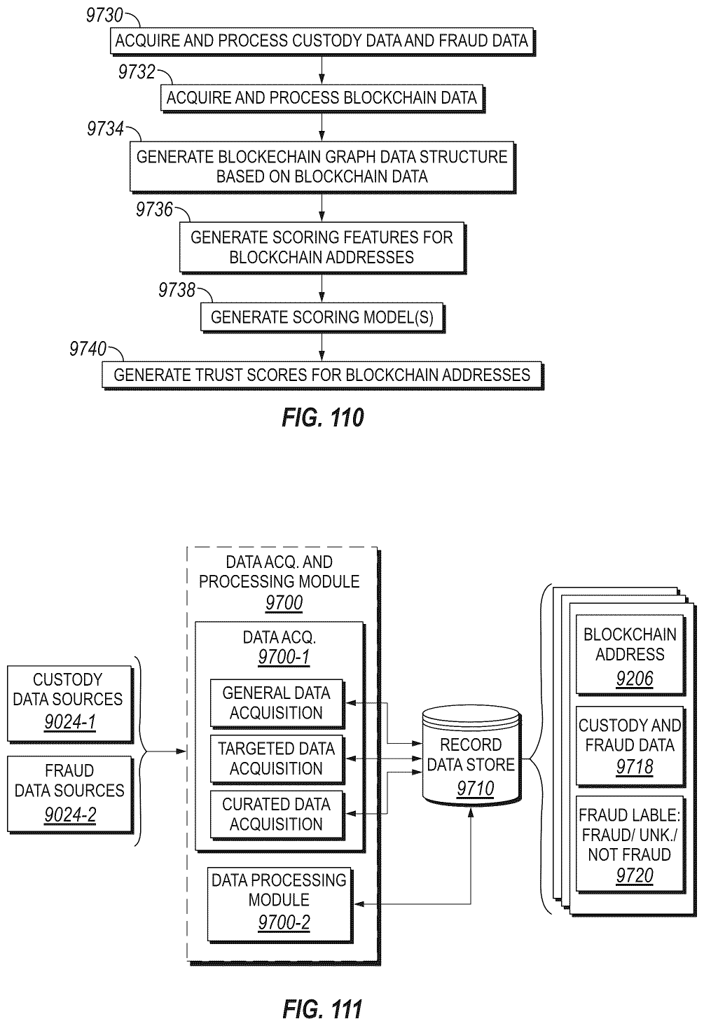

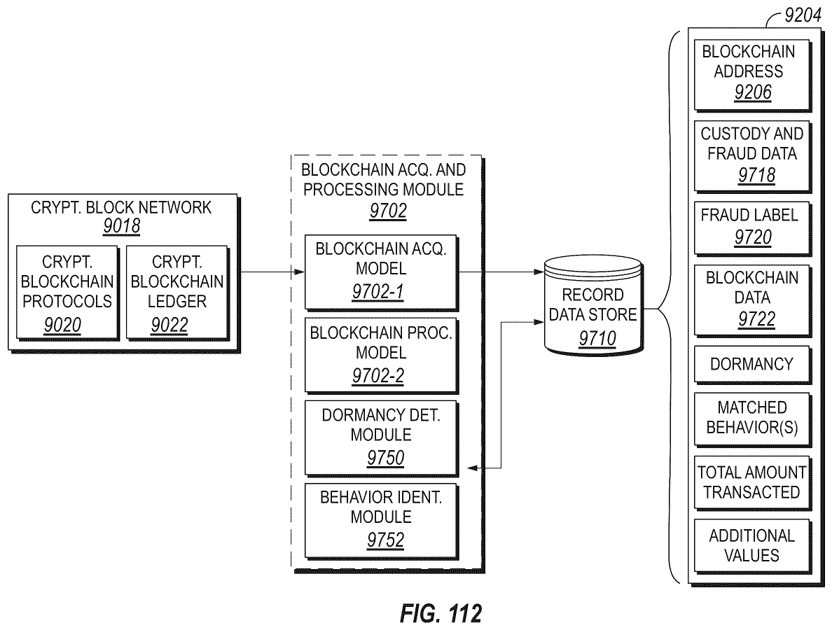

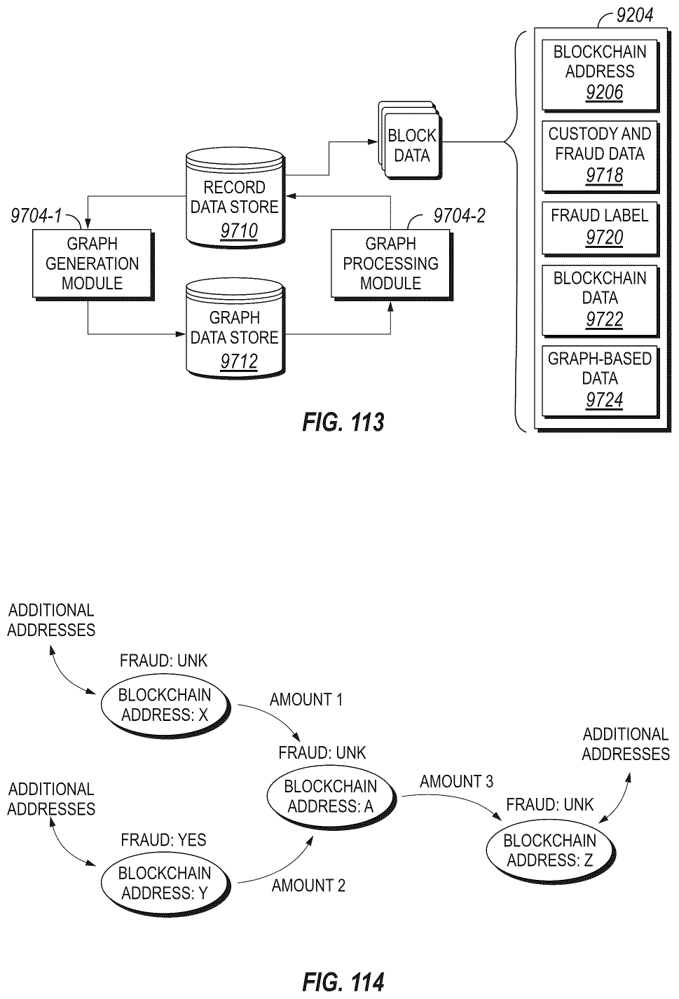

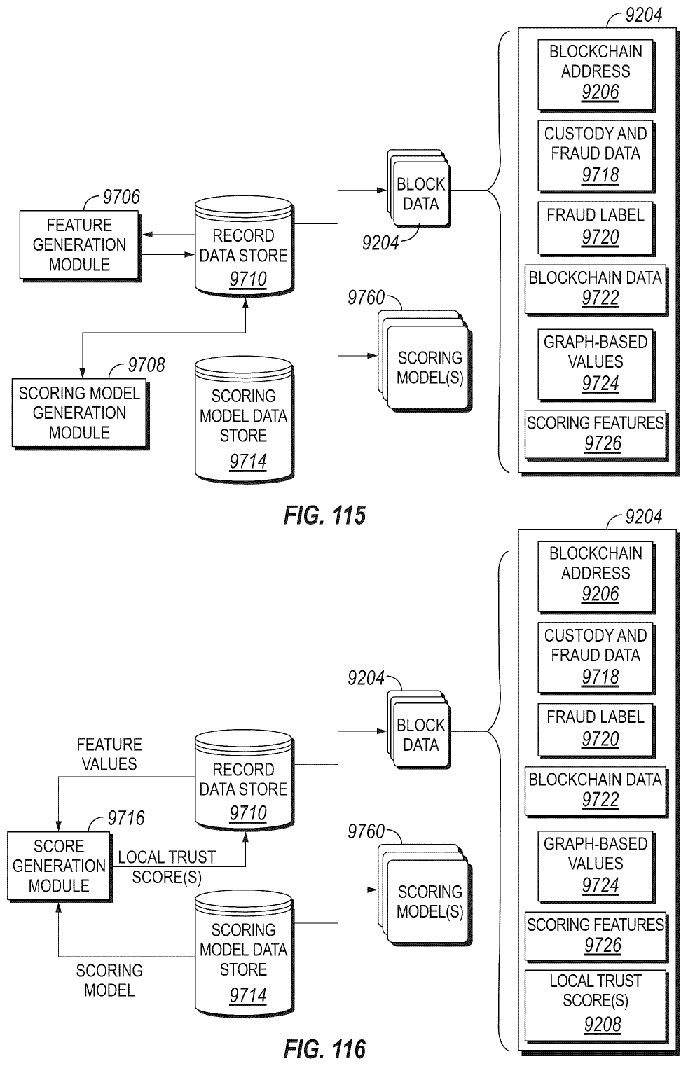

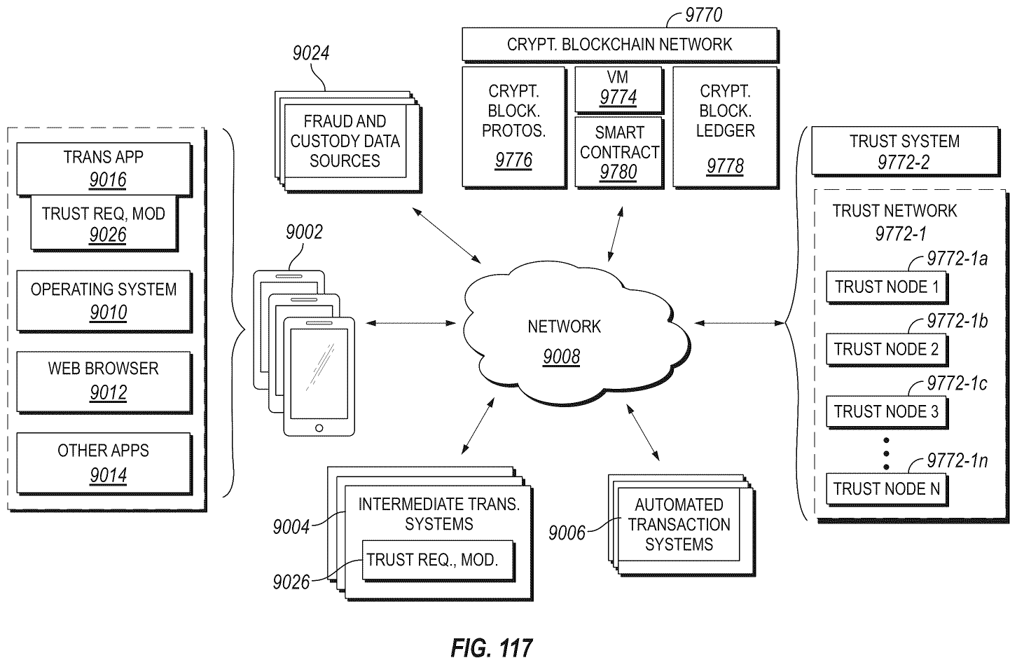

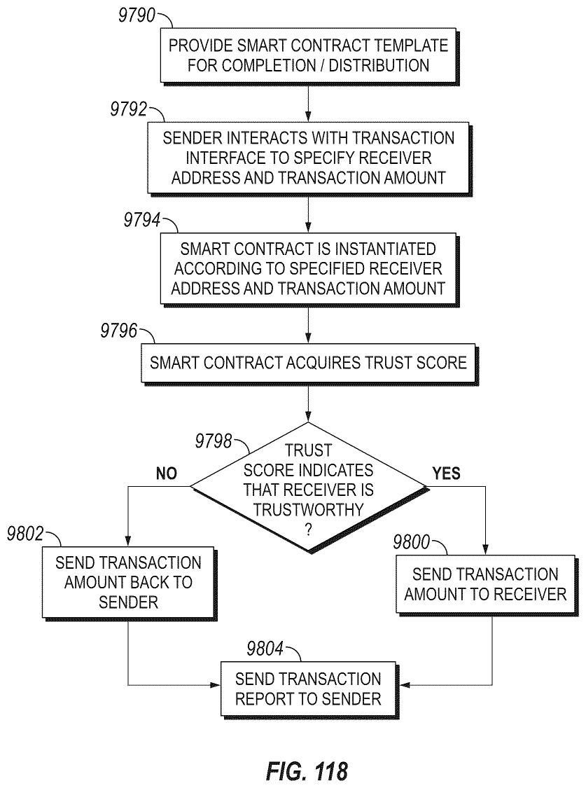

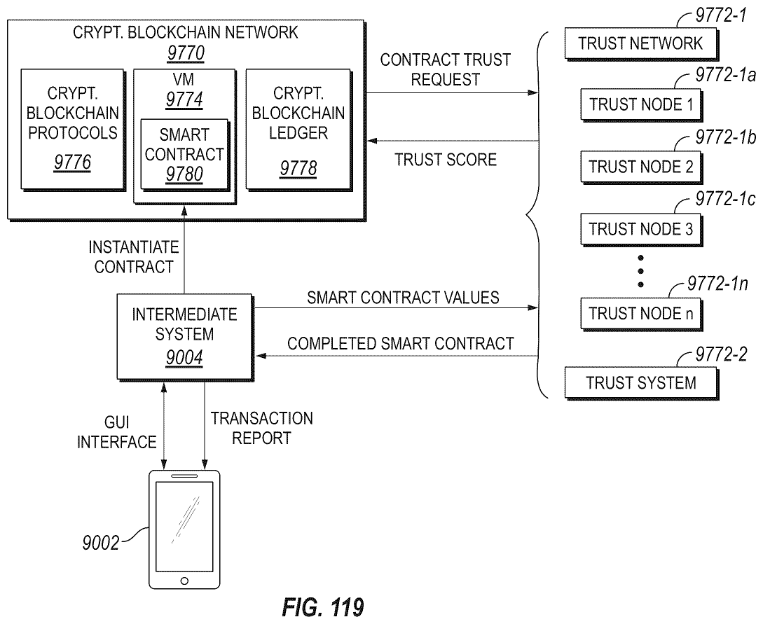

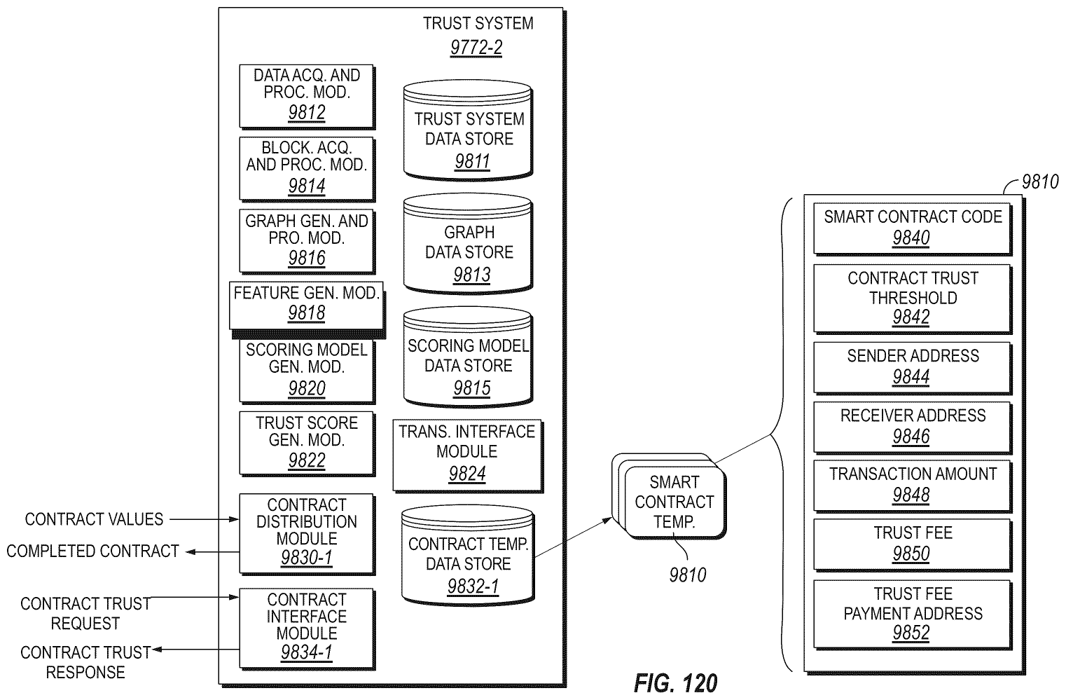

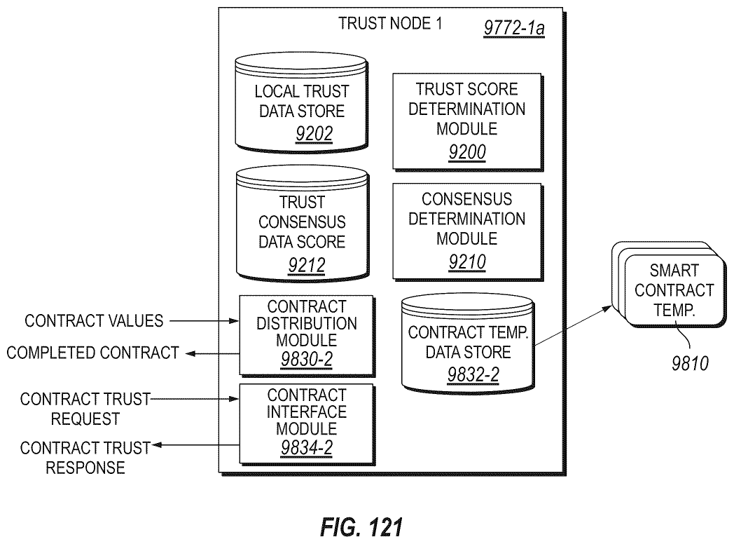

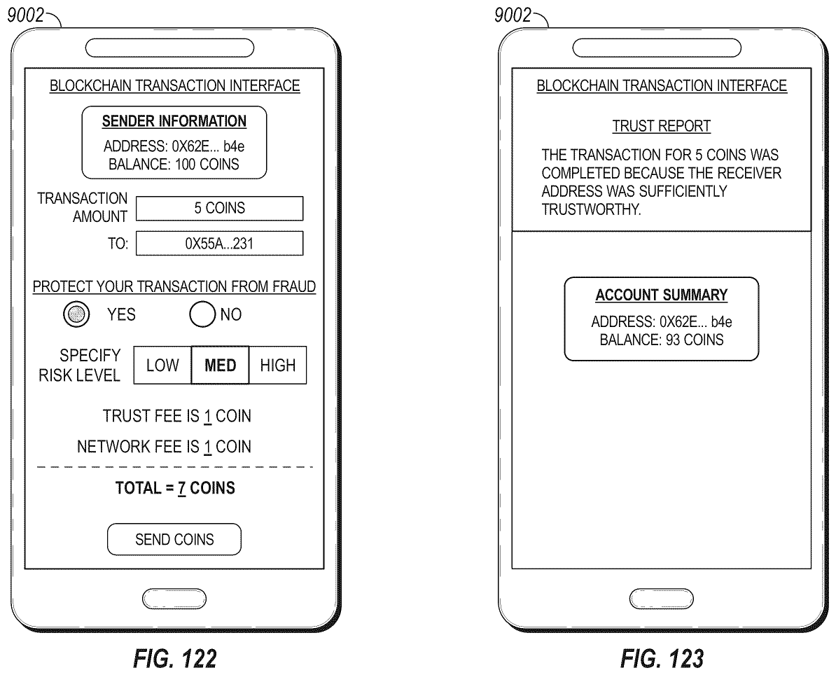

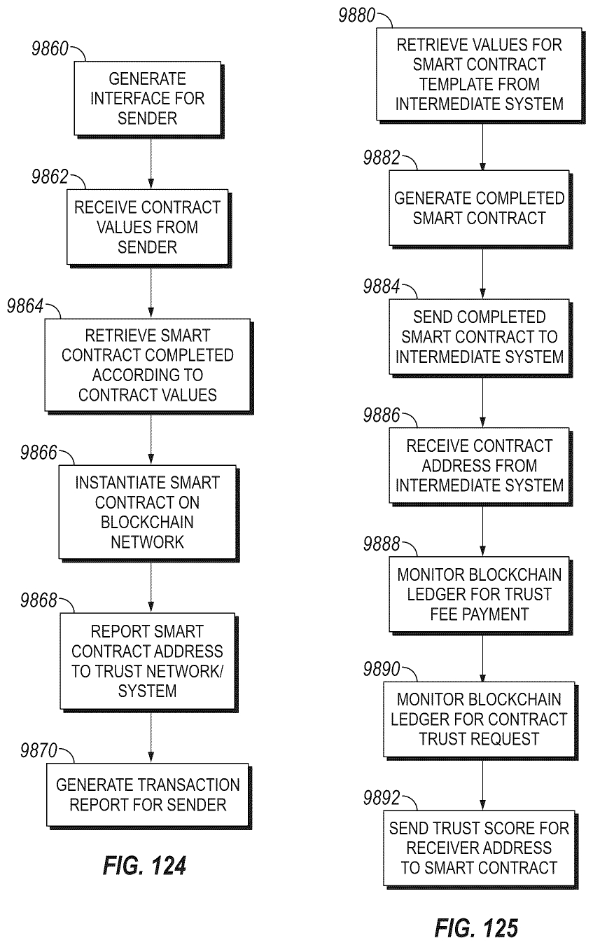

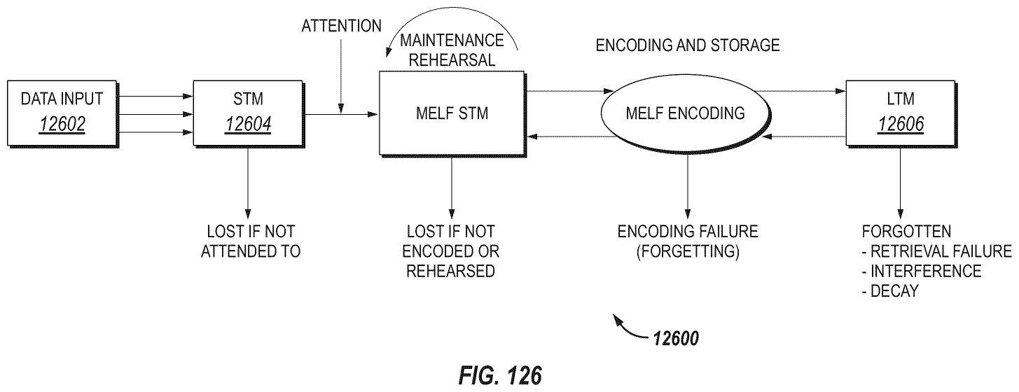

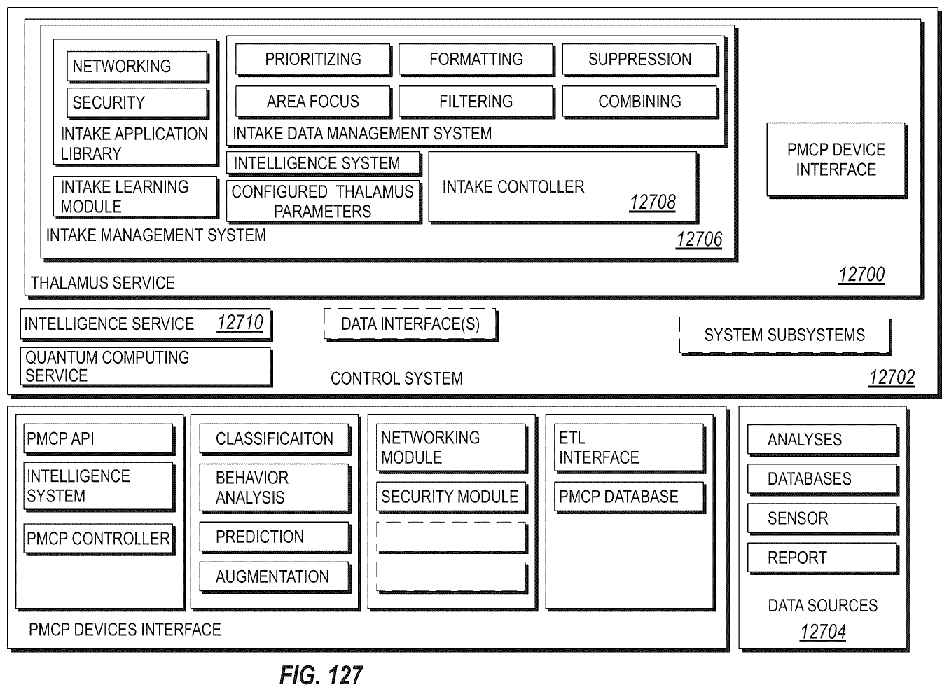

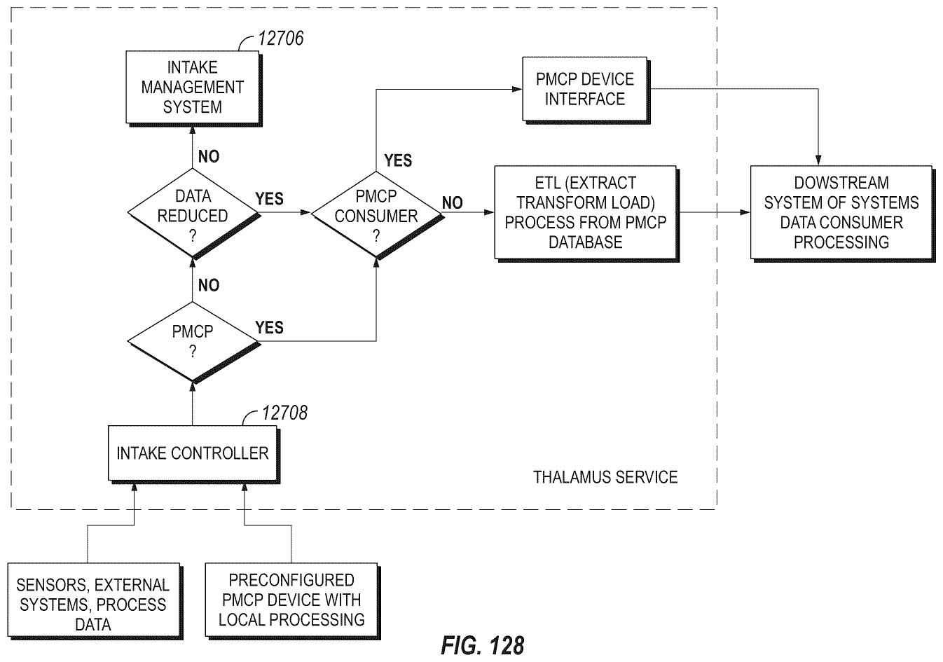

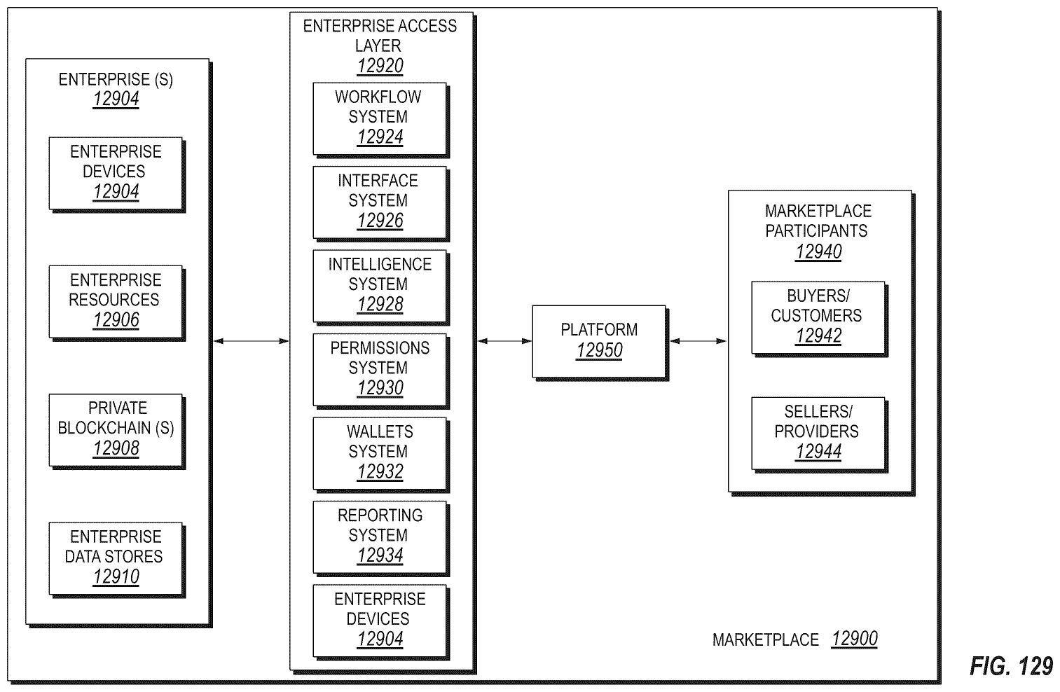

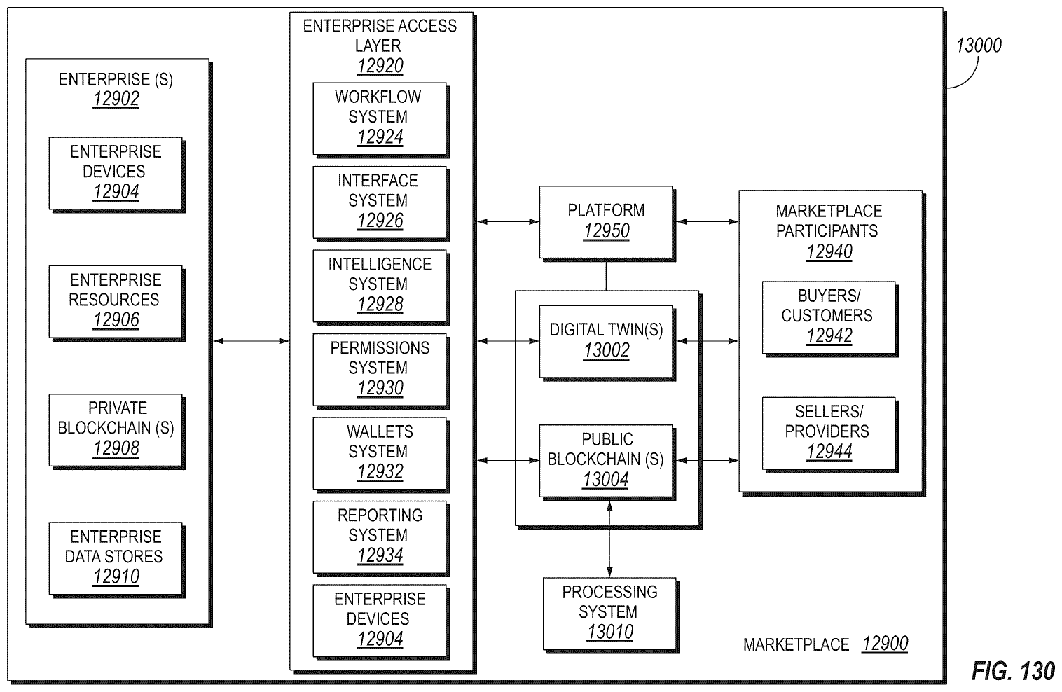

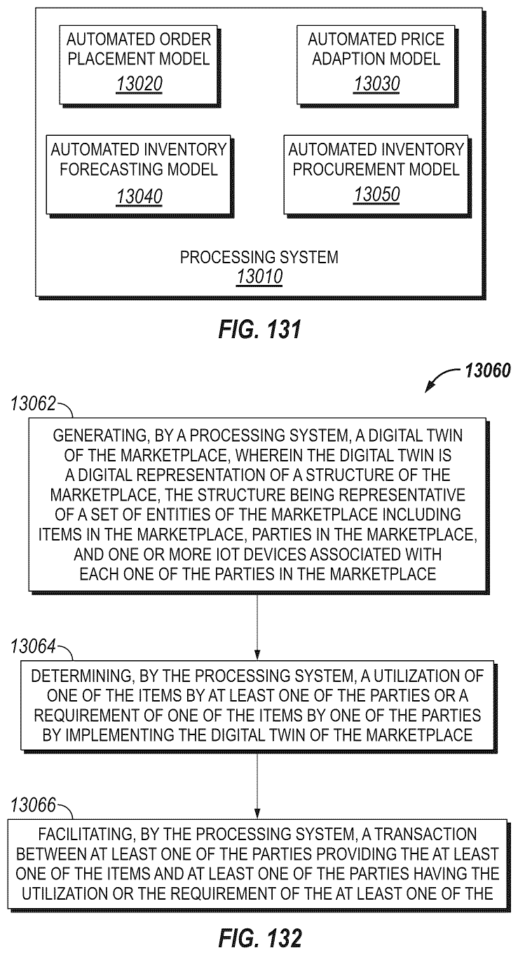

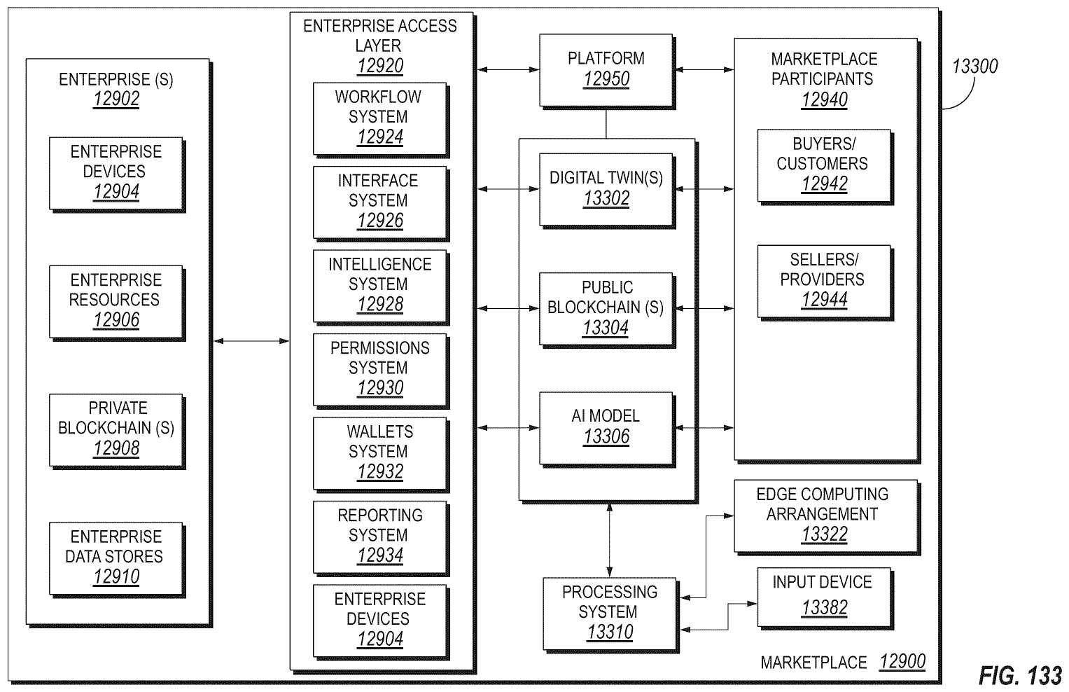

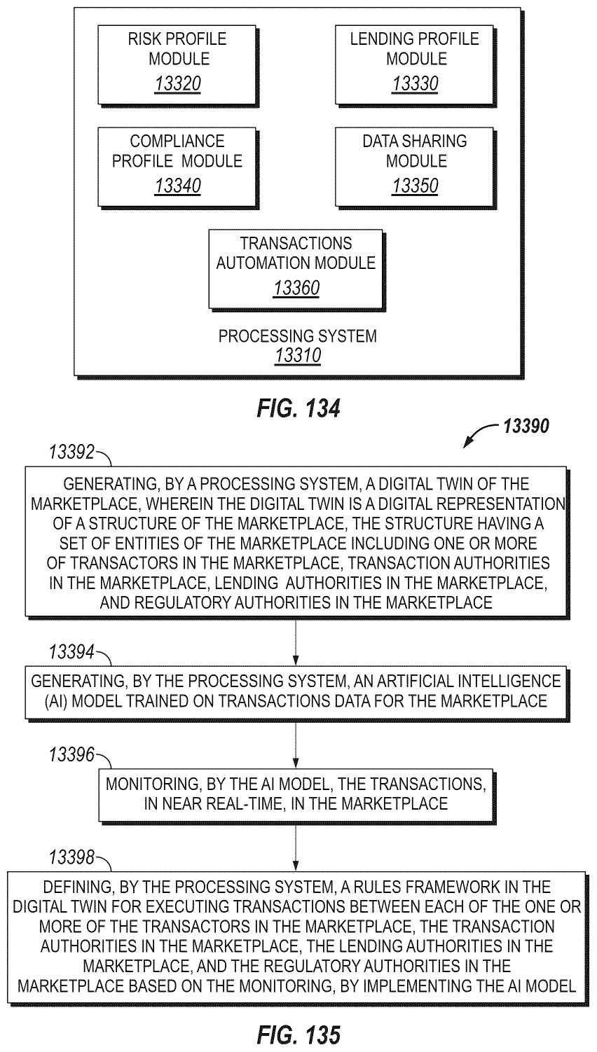

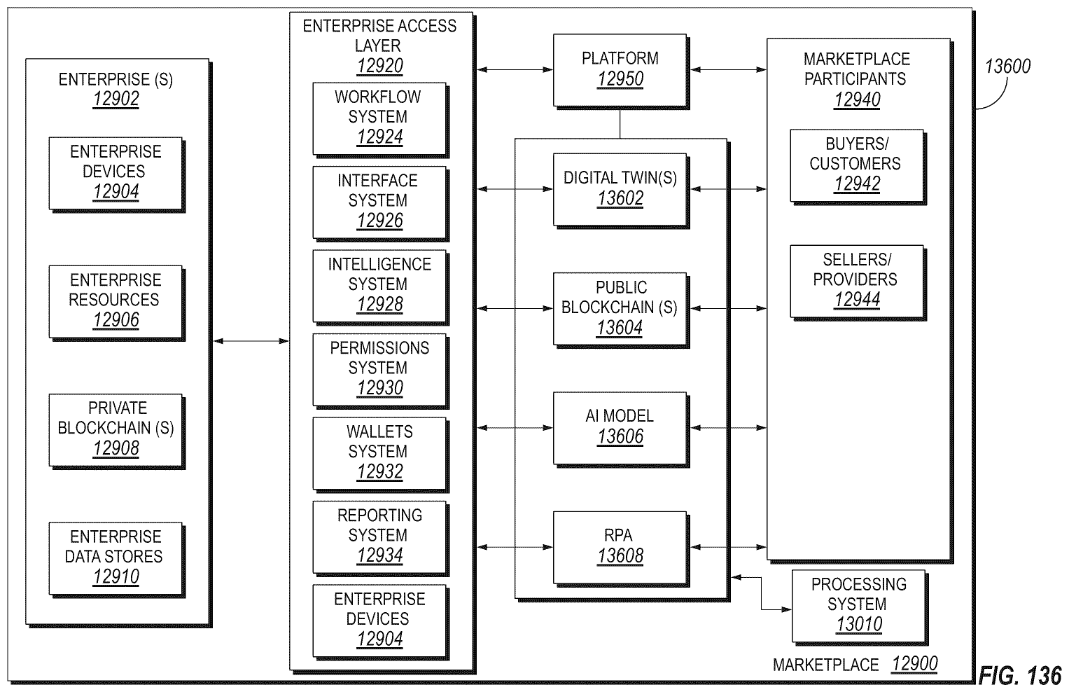

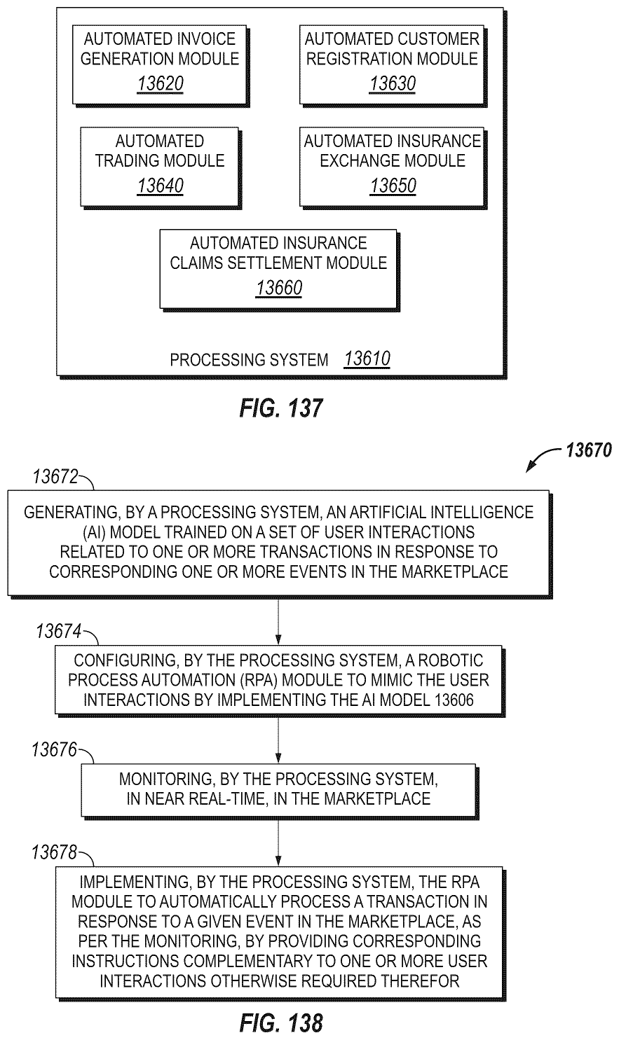

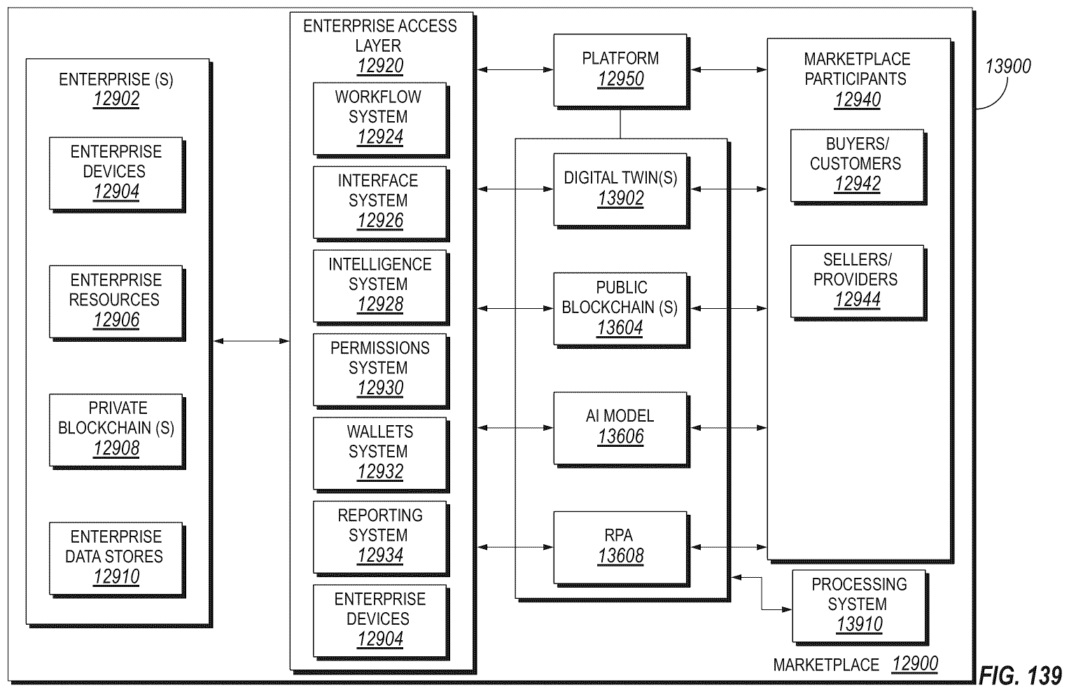

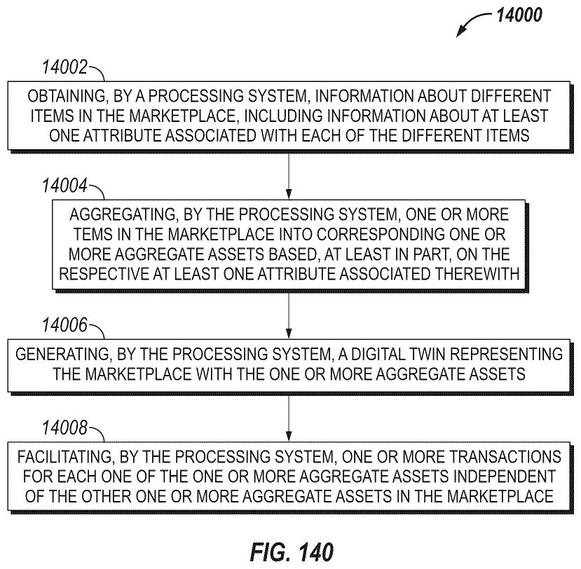

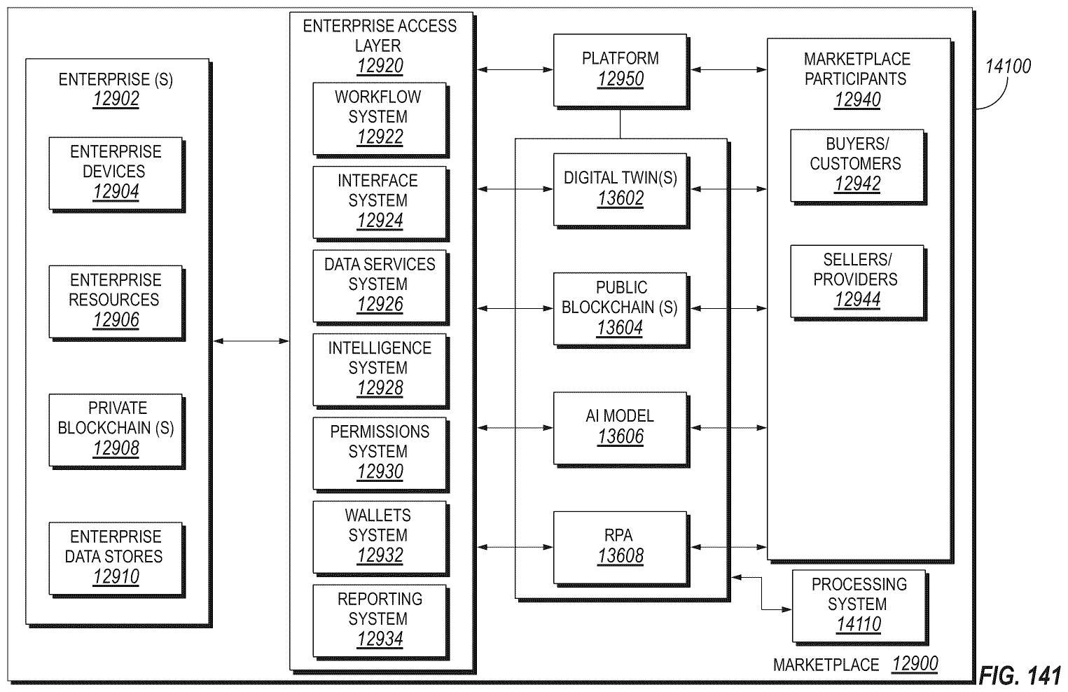

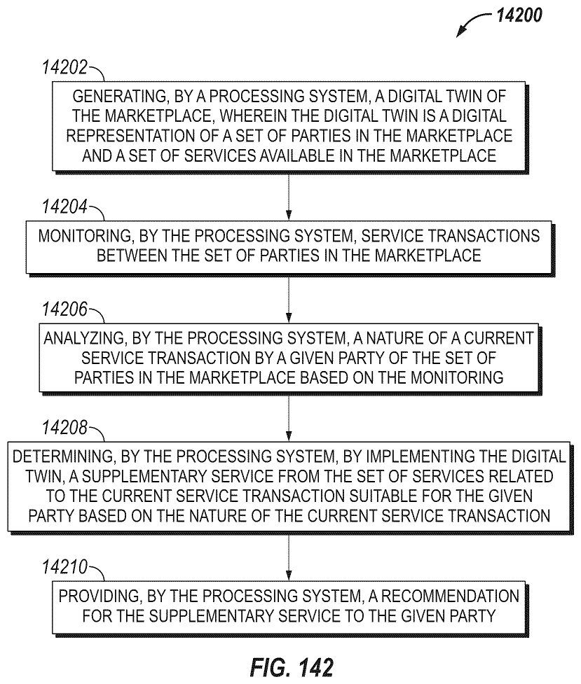

In some implementations, the intelligent services system 2143 performs machine learning and artificial intelligence related tasks on behalf of the market orchestration system platform 2400. In embodiments, the intelligent services system 2143 may train any suitable type of model, including but not limited to various types of neural networks, regression models, random forests, decision trees, Hidden Markov models, Bayesian models, and the like, including any of the expert and/or artificial intelligence examples described herein and, in the documents, incorporated by reference. In embodiments, the intelligent services system 2143 trains machine learned models using the output of simulations executed by the digital twin simulation system 2704 (FIG. 27) or other simulation system included in, integrated with, or linked to the platform 2400. In some of these embodiments, the outcomes of the simulations may be used to supplement training data collected from real-world environments and/or processes. In embodiments, the intelligent services system 2143 leverages machine learned models to make predictions, identifications, classifications, and recommendations; automate processes, perform marketplace configuration and control, and/or provide decision support relating to the marketplace and/or processes represented by respective digital twins.

For example, a set of machine-learned models may be used to predict the price of an asset at some future point in time. In embodiments, a “set” of machine-learned models may include a set with one member. In embodiments, a “set” of machine-learned models may include a set with multiple members. In embodiments, a “set” of machine-learned models may include hybrids of different types of models (e.g., hybrids of RNN and CNN). In this example, the intelligent services system 2143 may receive asset data, historical pricing data, discussion board data, and news data and may generate a set of feature vectors based on the received data. The intelligent services system 2143 may input the feature vector into the set of machine-learned models trained specifically for the asset (e.g., using a combination of simulation data and real-world data) to predict the price of the asset at a future point in time. In embodiments, the feature vector may include a set of predictions, such as ones made by human experts, by other systems, and/or by other models. Such artificial intelligence systems used for prediction (in this example and other examples described throughout this disclosure) may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to predict the probability of order execution for an order. In this example, the intelligent services system 2143 may receive order data, historical order data, and location data for the marketplace participant user device 2118 and may generate a set of feature vectors based on the received data. The intelligent services system 2143 may input the feature vectors into machine-learned models trained (e.g., using a combination of simulation data and real-world data) to predict the probability of order execution for an order, such as based on a training data set of outcomes. In embodiments, the system 2143 may include an input set of training data representing predictions or the probability of order execution by a set of human experts and/or by other systems or models.

In examples, a set of machine-learned models may be used to predict the profitability of a marketplace. In this example, the intelligent services system 2143 may receive marketplace configuration parameter data (e.g., asset type(s), fees, anonymity settings, and the like) and may generate a set of feature vectors based on the received data. The intelligent services system 2143 may input the feature vectors into machine-learned models trained (e.g., using a combination of simulation data and real-world data) to predict the profitability of a marketplace, such as based on a training data set of outcomes. In embodiments, the intelligent services system 2143 may include an input set of training data representing predictions related to marketplace profitability by a set of human experts and/or by other systems or models.

In yet other examples, a set of machine-learned models may be used to predict the execution speed for a marketplace at a given point in time. In this example, the intelligent services system 2143 may receive marketplace configuration parameter data and marketplace operational data and may generate feature vectors based on the received data. In embodiments, feature vectors may include other data, such as data characterizing information technology elements upon which execution speed may depend, including network path information (e.g., the type of fixed and/or wireless network, what networking protocols are used, the distance of physical layer paths, and the like); computational resource information (such as types and processing capabilities of servers and other data center resources, including, as applicable, availability of multi-core and/or multi-threaded processing, quantum computation and/or quantum algorithm execution, and the like, as well as edge computational capabilities that are available on premises involved in marketplace execution, in data centers that support cloud computing for marketplace execution and in local and telecommunications networks that support marketplace execution); data storage and retrieval information (such as input/output performance specifications for databases and other storage resources, caching performance capabilities, data location information (e.g., geo-location and federation of data resources), query performance information, and the like), and many others. The intelligent services system 2143 may input the feature vectors into machine-learned models trained (e.g., using a combination of simulation data and real-world data) to predict the execution speed for a marketplace at a given point in time from the point of view of a system that is at a given location (e.g., a geo-location, a network address, or the like). Prediction of execution speed may involve testing and simulation, such as using simulation methods and systems described herein, as well as in the documents incorporated by reference herein. This may include, in one non-limiting example, testing the latency, bandwidth, upload speed, download speed, round-trip speed, ping, or other network performance characteristics, such as by, optionally automatically, sending test signals that provide an indication of current network speed, execution speed, or the like.

In examples, a set of machine-learned models may be used to detect illicit and/or illegal items and/or services listed in a marketplace. In this example, the intelligent services system 2143 may receive asset listing data and may generate feature vectors based on the received data. The intelligent services system 2143 may input the feature vectors into machine-learned models trained (e.g., using a combination of simulation data and real-world data) to detect illicit and/or illegal items and/or services listed in the marketplace. In embodiments, detection of illicit and/or illegal items may involve a set of distinct models that are respectively trained based on training data sets and/or feature vector inputs that are specific to jurisdictional factors, including laws or regulations (e.g., training with awareness of legality), cultural factors (e.g., where whether the item is considered illicit varies based on cultural norms), religious factors (e.g., training the model with awareness of proscribed items), and the like. For example, a model may be trained to detect whether an item is kosher, whether it satisfies other cultural and/or religious requirements, or the like. In embodiments, training may include providing, such as through human experts, information about alternative terminology, or the like, that sellers or other users may employ to offer illegal or illicit items, such as code words, euphemisms, or the like. In embodiments, a model may be trained to provide a word cloud or cluster of words or other features, such as to facilitate recognition of illegal or illicit items and/or recognition of words, images, or other elements used to characterize them. As one non-limiting example, a self-organizing map (SOM) may be employed to generate a mapping of entities, such as mapping entities, classes, objects, workflows, or the like to jurisdictions, to topics, to each other, or the like.

In yet other examples, a set of machine-learned models may be used to detect trading patterns of a trader in a marketplace. In this example, the intelligent services system 2143 may receive trader data and order data and may generate feature vectors based on the received data. The intelligent services system 2143 may input the feature vectors into machine-learned models trained (e.g., using a combination of simulation data and real-world data) to detect trading patterns for a particular trader in the marketplace. In embodiments, trading patterns may be linked to strategies, such that the model may be used to determine a set of governing strategies, heuristics, models, rules, or other governing principles (collectively referred to for convenience as “strategies”) of a trader or other counterparty to a transaction. Thus, a machine-learned model may take various feature vectors related to marketplace activities and output a determination of a strategy of a party, such as a user or a counterparty. Such a determination may facilitate identification and optionally automated recommendation to a user of resources, such as data resources, models, predictions, and the like, that are consistent with and/or that support or enable the defined strategy. In other embodiments, such a determination may facilitate identification and optionally automated recommendations to a counterparty user, such as to assist the counterparty in identifying complementary strategies (e.g., where two parties are seeking opposite sides of the same type of trade) and/or competitive strategies (e.g., where the strategy of a counterparty makes the counterparty vulnerable to trading strategies). Models may be trained to recognize various strategies, such as arbitrage strategies (e.g., where a counterparty's strategy is likely to over- or under-value an asset class in a certain set of situations), squeeze strategies (such as a short squeeze where a counterparty has taken a large “short” position anticipating that an asset is overvalued, where a higher volume of orders that increase prices force the counterparty to abandon the short position due to growing risk), market cornering strategies, and the like. Feature vectors that may be used to train machine-learning models to identify trading patterns and strategies may include trade sizes, sequences (e.g., combinations of buy and sell orders in given sequences), position sizes (including short and long positions of assets, options, futures, derivatives and the like), trading volume metrics, relative sizes of positions (e.g., share of total market positions), market metrics (e.g., overall P/E ratios), external data (e.g., relating to general economic conditions, weather, geopolitical factors, and the like), and many others. In embodiments, automated, machine-learned strategy recognition enables further automation (including by robotic process automation, such as trained on strategic decisions of human experts) of marketplace strategy, including automated recommendation of trades and automated recommendation of complementary and competitive strategies. This may be referred to as a counterparty strategy engine, such term encompassing various capabilities by which the platform 2400 may employ machine learning and/or other intelligence capabilities to facilitate complementary and/or competitive trading strategies based on understanding the patterns and strategies of counterparties. Trading strategies that may be generated, detected, managed, or countered using artificial intelligence, such as machine-learned models described herein, may include a wide variety of strategies, including, without limitation: (a) buy and hold, or “fundamental” strategies (where input data sources and resulting feature vectors may be sought that relate to long-term fundamental performance, such as data sources relating to trends in asset class values, asset-related income streams (e.g., rents, royalties, interest rates, and the like), pricing and related metrics (such as P/E ratios), cost accounting information, tax information, exchange rate information, macroeconomic information (such as inflation information, unemployment information, gross domestic product information), and the like); (b) long/short equity strategies, such as ones that tranche securities into long and short buckets based on calculated alpha factors, with long positions taken on relatively favorable alpha assets or asset classes and short positions taken on relatively unfavorable alpha assets or asset classes (where input data sources and feature vectors include many of the same factors used for buy and hold strategies, with a particular interest in indicators of relative performance among securities or other assets, such as relative P/E ratios, relative historical asset class performance, or the like); (c) asset allocation strategies where parties allocate positions in portfolios among asset classes based on relative risk/return ratios that are suitable for a party; (d) intertemporal portfolio choice strategies involving bet (e.g., trade) sizing that is configured according to a defined proportion of wealth, such as using the Kelly criterion (where the bet size is calculated by maximizing the expected value of the logarithm of wealth), such as where data sources and feature vectors may involve information indicating the trades made by an identified party and information indicating the parties total wealth or capitalization; (e) pairs trading strategies where similar stocks are paired and a short position is taken on the top (potentially overpriced) asset and a long position is taken on the bottom (potentially underpriced) asset (which may optionally involve pairing similar stocks and using a linear combination (or other combination) of their price to generate a stationary time-series, computing a set of scores, such as z-scores, for the stationary signal and trading on the spread assuming reversion to the mean) where input data sources and feature vectors may include trading data that indicates trades of similar size and timing in pairs of similar assets; (f) swing trading strategies seeking to take advantage of volatility, where input data sources and feature vectors may relate to pricing information and patterns, as well as factors that may influence volatility (such as geopolitical data, social data, macroeconomic data, and the like); (g) scalping strategies (such as making very large numbers of trades during a trading session in order to seek to aggregate small profits from each trade based on a spread between the bid and the ask price for an asset) where input data sources and feature vectors may relate to trade volumes and sizes and the size of the average bid/ask spread, as well as many of the other sources and features noted above; (h) day trading strategies involving buying and selling within the same trading session, thereby closing out positions during periods when the market is not operating, which may involve data sources and feature vectors that indicate complementary pairs (e.g., a buy and a sell) of trades of the same quantity of the same asset during a trading session, among others; (i) news-based or information-based trading strategies involving rapidly anticipating the impact of news events or other emerging information on asset prices, which may involve data sources and feature vectors that help predict or anticipate news (e.g., using predictive models), that help identify relevant events in real-time (such as Internet of Things sources, crowdsources, social data sites, websites, news feeds, and many others) and data sources that indicate historical trends, such as reactions to similar news or events in past trading involving the same or similar asset classes; (j) market timing strategies, including signal-based trading strategies, momentum trading strategies, and the like, involving timing the purchase or sale of an asset class based on market signals, which may use a wide variety of sources used by signals providers to produce aggregate forecasts of market signals as well as other information that indicates patterns of reaction of markets to new information and events; (k) social trading strategies, such as involving trading based on behavioral models of counterparty trading, which may involve data sources and feature vectors that reflect trading behavior, such as trading volume data, price pattern data, and the like, in response to market conditions, events and stimuli, including many of the data sources and feature vectors mentioned herein; (l) front-running strategies (involving detecting indicators of trading intent by a counterparty and rapidly executing a trade before the intent is realized in the form of an actual trade by the counterparty); (m) chart-based or pattern-based strategies, where trading is based on analysis of charts, such as trends in pricing of trades over a session or series of sessions, such as ones that seek to anticipate future movements in prices based on patterns of past movement (e.g., anticipating an upward surge after a “cup with a handle” price pattern), which are typically based on some underlying behavioral model of aggregate trading behavior of a set of traders in a marketplace and which may use data source or feature vectors that indicate patterns of market behavior and market outcomes, such as trend charts and other visual information on patterns; (n) genetic programming, deep learning, or other computer science-based strategies (such as involving introducing a degree of random or non-random variation into a trading algorithm or model, such as a variation of data source, feature vector, feedback source, weighting, type of neural network, or the like used in an artificial intelligence system, variation of trading patterns (size, timing, price, volume), variation in asset class, variation of strategy, or the like), such as where data sources of feature vectors may be identified that relate to patterns, trends or changes in any of the above within marketplace trading data; (o) automated or algorithmic trading strategies (which may be used to implement any of the foregoing and other strategies), where marketplace trading data sources may be used to identify trading patterns that indicate very rapid execution or other patterns that are markers of algorithmic execution; (p) various hybrids and combinations of the foregoing; and various other trading strategies used in any of a wide range of asset classes and marketplaces described herein. Such artificial intelligence systems used for detection or identification (in this example and other examples described throughout this disclosure) may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In yet other examples, a set of machine-learned models may be used to detect an opportunity for a new marketplace. For example, the intelligent services system 2143 may receive data from various sources described throughout this document and the documents incorporated by reference herein and may generate a set of feature vectors based on the received data. The intelligent services system 2143 may input the set of feature vectors into machine-learned models trained (e.g., using a combination of simulation data and real-world data) to detect an opportunity for a new marketplace. Data sources used to produce the set of feature vectors may include, for example, discussion boards (such as involving chats, comment threads or the like about deals, trades, asset types, streams of value, or the like that may be organized into a marketplace), social media sites (such as involving posts or threads involving assets that can be traded, deals, or the like), websites (such as announcing products, services, offerings, events, or the like), and others. As one non-limiting example, content from a set of websites and social media sites involving events (such as ones hosted by event organizers, event participants, fans, followers, and others) may be fed to a machine-learned model that may be trained to operate on the feature vectors, such as using a neural network (such as an RNN, CNN, SOM or hybrid, among many other options), to output a candidate set of events that may be suitable candidates for a contingent forward market for rights to the event. The model may be trained, for example, to identify events that are likely to be very popular (such as involving popular talent, popular teams, or the like) and to identify cases in which some aspect of the event remains contingent, such as timing, location, actual participants, and the like, meaning that a contingency can be set for rights (e.g., attendance rights, accommodation rights, transportation rights, and many others) in the forward market. Output from the model can thus be used as a candidate set for the contingent forward market operator. In examples, product websites content may be fed to the model, which may be trained to identify new product or service offerings relevant to a particular cohort of buyers, which may be automatically grouped by the model (or another model) into a cohort-targeted marketplace of similar buyers.

In examples, a set of machine-learned models may be used to identify optimal trading opportunities. For example, the intelligent services system 2143 may receive data from various sources described throughout this document and the documents incorporated by reference herein and may generate a set of feature vectors based on the received data. The intelligent services system 2143 may input the set of feature vectors into machine-learned models trained (e.g., using a combination of simulation data and real-world data) to identify optimal trading opportunities, such as based on a training data set of outcomes. In embodiments, the intelligent services system 2143 may include an input set of training data representing identifications related to optimal marketplace trading opportunities by a set of human experts and/or by other systems or models. Data sources that may be used to produce feature vectors may include, for example, time of day, location of price, moving averages, performance of correlated assets, performance of indexes, discussion boards (such as involving chats, comment threads or the like about deals, trades, trends, or the like), websites (such as announcing products, services, offerings, events, or the like), and many others.

In examples, a set of machine-learned models may be used to detect fraudulent asset listings. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to detect fraudulent asset listings, such as based on a training data set of outcomes. In embodiments, the intelligent services system 2143 may include an input set of training data representing detection related to fraudulent listings by a set of human experts and/or by other systems or models. In embodiments, training may include providing information related to identical and/or similar asset listings that may have been fraudulently duplicated. In embodiments, a model may be trained to provide a word cloud or cluster of words or other features, such as to facilitate recognition of fraudulent listings and/or recognition of words, images, or other elements used to characterize them. Data sources that may be used to produce feature vectors may include, for example, websites (such as websites listing assets, products, services, offerings, or the like), pricing data (such as unusually low pricing), asset description data (such as overly generic asset descriptions or illiterate asset descriptions), and many others.

In examples, a set of machine-learned models may be used to detect market behavior for an asset. For example, the intelligent services system 2143 may receive data from various sources described throughout this document and the documents incorporated by reference herein and may generate a set of feature vectors based on the received data. The intelligent services system 2143 may input the feature vector into machine-learned models trained (e.g., using a combination of simulation data and real-world data) to detect market behavior around a particular asset, such as based on a training data set of outcomes. In embodiments, the intelligent services system 2143 may include an input set of training data representing detection related to market behavior by a set of human experts and/or by other systems or models. Data sources that may be used to produce feature vectors may include trade sizes, sequences (e.g., combinations of buy and sell orders in given sequences), position sizes (including short and long positions of assets, options, futures, derivatives, and the like), trading volume metrics, relative sizes of positions (e.g., share of total market positions), market metrics (e.g., overall P/E ratios), and many others.

In examples, machine-learned models may be used to identify trending assets. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to identify trending assets, such as based on a training data set of outcomes. In embodiments, the intelligent services system 2143 may include an input set of training data representing detection related to trending assets by a set of human experts and/or by other systems or models. Data sources used to produce the set of feature vectors may include, for example, discussion boards (such as involving chats, comment threads involving assets, or the like), social media sites (such as involving posts or threads involving assets or the like), websites (such as news involving assets or the like), and others. In examples, a set of machine-learned models may be used to determine market sentiment for a particular asset. For example, the intelligent services system 2143 may receive data from various sources described throughout this document and the documents incorporated by reference herein and may generate a set of feature vectors based on the received data. The intelligent services system 2143 may input the feature vector into machine-learned models trained (e.g., using a combination of simulation data and real-world data) to determine market sentiment for the asset, such as based on a training data set of outcomes. In embodiments, the intelligent services system 2143 may include an input set of training data representing determinations related to market sentiment by a set of human experts and/or by other systems or models. Data sources used to produce the set of feature vectors may include, for example, discussion boards (such as involving chats, comment threads involving assets or the like), social media sites (such as involving posts or threads involving assets or the like), external (such as news involving assets or the like), trading data, volume data, upside/downside volume ratio data, trader data (scanning many markets to find parties who have ever traded in the asset class or similar asset classes), data indicating focus (e.g., websites of capital allocators indicating areas of focus), data indicating strategies (indicators of the general strategy of the trader, such as “buy and hold,” “arbitrage,” “day trading”, and many others, which can be used to recruit parties who favor the behavior of the asset class (e.g., high within-session volatility for day traders versus long-term fundamental value aggregation (e.g., growing income streams) for buy-and-hold)), trading news data, survey data, open interest data (e.g., total number of futures contracts or options that are held by traders), put-call ratio data, volatility index (VIX) data, commitment of traders (COT) data, high-low index data, crowdsourced data, short-term trading index (TRIN) data, advance/decline ratio data, NYSE high/low ratio data, NYSE bullish percent index data, data collected by IoT systems (e.g., smart home IoT devices, workplace IoT devices, and the like) to monitor a set of entities in a set of environments, and many others.

Such artificial intelligence systems used for decision-making or other determinations (in this example and other examples described throughout this disclosure) may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to identify counterparties with complementary trading positions and/or strategies. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to identify counterparties with complementary trading positions and/or strategies, such as based on a training data set of outcomes. In embodiments, the intelligent services system 2143 may include an input set of training data representing identifications related to counterparties with complementary trading positions and/or strategies by a set of human experts and/or by other systems or models. In embodiments, automated, machine-learned counterparty recognition enables further automation (including by robotic process automation, such as trained on strategic decisions of human experts) of marketplace strategy. The counterparty strategy engine may employ machine learning and/or other intelligence capabilities to facilitate counterparty discovery based on understanding the patterns and strategies of counterparties. Data sources used to produce the set of feature vectors may include, for example, trading data (scanning many markets to find parties who have ever traded in the asset class or similar asset classes), data indicating strategies (indicators of the general strategy of the trader, such as “buy and hold,” “arbitrage,” “day trading”), trader profile data, and many others.

In examples, a set of machine-learned models may be used to detect potential marketplace participants for marketplace recruitment purposes. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to detect potential marketplace participants, such as based on a training data set of outcomes. In embodiments, the intelligent services system 2143 may include an input set of training data representing detection related to potential marketplace participants by a set of human experts and/or by other systems or models. Data sources used to produce the set of feature vectors may include, for example, trading data (scanning many markets to find parties who have ever traded in the asset class or similar asset classes), data indicating focus (e.g., websites of capital allocators indicating areas of focus), data indicating strategies (indicators of the general strategy of the trader, such as “buy and hold,” “arbitrage,” “day trading”, and many others, which can be used to recruit parties who favor the behavior of the asset class (e.g., high within-session volatility for day traders versus long-term fundamental value aggregation (e.g., growing income streams) for buy-and-hold)), and many others.

In examples, a set of machine-learned models may be used to provide decision support related to configuration of a marketplace. In embodiments, the decision support may be provided by a marketplace configuration decision support platform. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to provide decision support related to configuration of a marketplace, such as based on a training data set of outcomes. In embodiments, the intelligent services system 2143 may include an input set of training data representing decision support related to marketplace configuration by a set of human experts and/or by other systems or models. In some embodiments, the decision support may relate to guidance on marketplace anonymity settings, fee settings, transaction type (e.g., buy-sell, auction, reverse auction, or the like), listing requirements, supported trading types, and the like. In the present example, the intelligent services system 2143, which may receive asset data (optionally including asset demand data, supply data, cost data, volatility data, pricing pattern data, trade size data, trade volume data, geographic trading data, trading party profile data, previous close data, open data, low data, high data, price data, change data, change percent data, 52 week low data, 52 week high data, shares outstanding data, market capitalization data, price-to-earnings (P/E) data, beta data, asset/instrument type data, industry data, employee data, last trade time data, asset location data, asset condition data, asset performance data, asset dimension data, asset brand data, asset material data, and/or many other types of asset-related data), marketplace profitability data, laws or regulations (e.g., training with awareness of legality), and many others.

In some examples, the marketplace configuration-related decision support may relate to guidance on marketplace anonymity settings, fee settings, supported transaction types (e.g., buy-sell, auction, reverse auction, or the like), asset listing requirements, whether futures trading mechanisms are enabled, whether price arbitrage mechanisms are enabled, whether derivatives trading mechanisms are enabled, supported trading types, selection of data storage and use policies, and many others described throughout this document and documents incorporated by reference herein.

In examples, a set of machine-learned models may be used to provide decision support related to the pricing of one or more assets. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to provide decision support related to the pricing of one or more assets, such as based on a training data set of outcomes. In embodiments, the intelligent services system 2143 may include an input set of training data representing decision support related to asset pricing by a set of human experts and/or by other systems or models. Data sources used to produce the set of feature vectors, may include, but are not limited to, asset data (optionally including asset demand data, supply data, cost data, volatility data, pricing pattern data, trade size data, trade volume data, geographic trading data, trading party profile data, and/or many other types of asset-related data), discussion boards (such as involving chats, comment threads involving assets or the like), social media sites (such as involving posts or threads involving assets or the like), external (such as news involving assets or the like), and others.

In examples, a set of machine-learned models may be used to provide decision support related to order request parameters (e.g., pricing, quantity, action type, and the like). For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to provide decision support related to order request parameters, such as based on a training data set of outcomes. In embodiments, the system 2143 may include an input set of training data representing decision support related to order request parameters by a set of human experts and/or by other systems or models. Data sources used to produce the set of feature vectors, may include, but are not limited to, pricing data, profitability data, operational data, product or service performance data, liability data, party performance data, market data (e.g., price trends, volatility, and others), and many others.

In examples, a set of machine-learned models may be used to provide decision support related to cancelling orders. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to provide decision support related to order cancellation, such as based on a training data set of outcomes. In embodiments, the intelligent services system 2143 may include an input set of training data representing decision support related to cancelling orders by a set of human experts and/or by other systems or models. Data sources used to produce the set of feature vectors, may include, but are not limited to, asset data (optionally including asset demand data, supply data, cost data, volatility data, pricing pattern data, trade size data, trade volume data, geographic trading data, trading party profile data, and/or many other types of asset-related data), external data (such as news involving assets or the like), and others.

In examples, a set of machine-learned models may be used to provide decision support related to setting smart contract parameters (e.g., pricing, quantity, delivery, and the like). Taking the example further, for a smart contract related to replacement part for a machine, the intelligent services system 2143 may receive historical and current data from or about the machine and/or a facility in which it is located and may generate a set of feature vectors based on the received data. The intelligent services system 2143 may input the set of feature vectors into a machine-learned model trained (e.g., using a combination of simulation data and real-world data) to provide decision support related to setting smart contract parameters. In embodiments, a model or set of models may be trained by an expert in the replacement parts and service marketplace to configure appropriate price, service, and delivery terms and conditions for replacement of the part for the machine, based on the historical and current data. Smart contract configuration may involve sets of feature vectors using or derived from historical contract performance data, including pricing data, profitability data, operational data, product or service performance data, liability data, data indicative of failure rates (e.g., product faults, service failures, delivery failures, and many others), party performance data, market data (e.g., price trends, volatility, and others), and many others.

In yet other examples, a set of machine-learned models may be used to determine regulatory compliance of a marketplace, a trader, a broker, a trade, an asset listing, a holder of inside information, or the like. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to determine regulatory compliance. As one non-limiting example, regulatory compliance may include compliance with regulations that prohibit holders of inside information from signaling the market in advance of trading activities to their benefit. In embodiments, relating to such an example, a machine-learned model may parse large bodies of material, such as press releases, podcasts, interviews, and the like, such as to find instances of signaling. In embodiments, automated identification of similar content, and respective timing, among public, or semi-public communications, trading activities, and content of securities filings may be performed to identify suspicious sequences, such as where a trade was followed by a public statement that impacted the value of the trade. In examples, the machine-learned model may parse trades, and trade timing, along with evidence of party relatedness (e.g., social media connections) to find indications of insider trading where an inside party has tipped an outside party, such as a family member, a business associate, a colleague, or the like. Embodiments extend to policy compliance, such as for marketplaces where insider trading is not prohibited but would be frowned upon if discovered to be done, such as where parties are rated based on the extent of their inside trading activity.

In yet other examples, a set of machine-learned models may be used to generate a trading strategy. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to generate a trading strategy. Generation of a trading strategy may be trained on outcomes, including by use of various metrics that indicate trading strategy performance, optionally including risk-adjusted strategy performance, such as Sharpe ratios, multiples on invested capital, investment rates of return (IRRs), cost-adjusted return metrics, benchmark comparisons (e.g., benchmarking against an index fund), and many others.

Trading strategies that may be generated, detected, managed, or countered using artificial intelligence, such as machine-learned models described herein, may include a wide variety of strategies, including, without limitation: (a) buy and hold, or “fundamental” strategies (where input data sources and resulting feature vectors may be sought that relate to long-term fundamental performance, such as data sources relating to trends in asset class values, asset-related income streams (e.g., rents, royalties, interest rates, and the like), pricing and related metrics (such as P/E ratios), cost accounting information, tax information, exchange rate information, macroeconomic information (such as inflation information, unemployment information, gross domestic product information), and the like); (b) long/short equity strategies, such as ones that tranche securities into long and short buckets based on calculated alpha factors, with long positions taken on relatively favorable alpha assets or asset classes and short positions taken on relatively unfavorable alpha assets or asset classes (where input data sources and feature vectors include many of the same factors used for buy and hold strategies, with a particular interest in indicators of relative performance among securities or other assets, such as relative P/E ratios, relative historical asset class performance, or the like); (c) asset allocation strategies where parties allocate positions in portfolios among asset classes based on relative risk/return ratios that are suitable for a party; (d) intertemporal portfolio choice strategies involving bet (e.g., trade) sizing that is configured according to a defined proportion of wealth, such as using the Kelly criterion (where the bet size is calculated by maximizing the expected value of the logarithm of wealth), such as where data sources and feature vectors may involve information indicating the trades made by an identified party and information indicating the parties total wealth or capitalization; (e) In pairs trading strategies where similar stocks are paired and a short position is taken on the top (potentially overpriced) asset and a long position is taken on the bottom (potentially underpriced) asset (which may optionally involve pairing similar stocks and using a linear combination (or other combination) of their price to generate a stationary time-series, computing a set of scores, such as z-scores, for the stationary signal and trading on the spread assuming reversion to the mean) where input data sources and feature vectors may include trading data that indicates trades of similar size and timing in pairs of similar assets; (f) swing trading strategies seeking to take advantage of volatility, where input data sources and feature vectors may relate to pricing information and patterns, as well as factors that may influence volatility (such as geopolitical data, social data, macroeconomic data, and the like); (g) scalping strategies (such as making very large numbers of trades during a trading session in order to seek to aggregate small profits from each trade based on a spread between the bid and the ask price for an asset) where input data sources and feature vectors may relate to trade volumes and sizes and the size of the average bid/ask spread, as well as many of the other sources and features noted above; (h) day trading strategies involving buying and selling within the same trading session, thereby closing out positions during periods when the market is not operating, which may involve data sources and feature vectors that indicate complementary pairs (e.g., a buy and a sell) of trades of the same quantity of the same asset during a trading session, among others; (i) news-based or information-based trading strategies involving rapidly anticipating the impact of news events or other emerging information on asset prices, which may involve data sources and feature vectors that help predict or anticipate news (e.g., using predictive models), that help identify relevant events in real-time (such as Internet of Things sources, crowdsources, social data sites, websites, news feeds and many others) and data sources that indicate historical trends, such as reactions to similar news or events in past trading involving the same or similar asset classes; (j) market timing strategies, including signal-based trading strategies, momentum trading strategies and the like, involving timing the purchase or sale of an asset class based on market signals, which may use a wide variety of sources used by signals providers to produce aggregate forecasts of market signals, as well as other information that indicates patterns of reaction of markets to new information and events; (k) social trading strategies, such as involving trading based on behavioral models of counterparty trading, which may involve data sources and feature vectors that reflect trading behavior, such as trading volume data, price pattern data, and the like, in response to market conditions, events and stimuli, including many of the data sources and feature vectors mentioned herein; (l) front-running strategies (involving detecting indicators of trading intent by a counterparty and rapidly executing a trade before the intent is realized in the form of an actual trade by the counterparty); (m) chart-based or pattern-based strategies, where trading is based on analysis of charts, such as trends in pricing of trades over a session or series of sessions, such as ones that seek to anticipate future movements in prices based on patterns of past movement (e.g., anticipating an upward surge after a “cup with a handle” price pattern), which are typically based on some underlying behavioral model of aggregate trading behavior of a set of traders in a marketplace and which may use data source or feature vectors that indicate patterns of market behavior and market outcomes, such as trend charts and other visual information on patterns; (n) genetic programming, deep learning, or other computer science-based strategies (such as involving introducing a degree of random or non-random variation into a trading algorithm or model, such as a variation of data source, feature vector, feedback source, weighting, type of neural network, or the like used in an artificial intelligence system, variation of trading patterns (size, timing, price, volume), variation in asset class, variation of strategy, or the like), such as where data sources of feature vectors may be identified that relate to patterns, trends or changes in any of the above within marketplace trading data; (o) automated or algorithmic trading strategies (which may be used to implement any of the foregoing and other strategies), where marketplace trading data sources may be used to identify trading patterns that indicate very rapid execution or other patterns that are markers of algorithmic execution; (p) various hybrids and combinations of the foregoing; and various other trading strategies used in any of a wide range of asset classes and marketplaces described herein.

In yet other examples, a set of machine-learned models may be used to detect a trading strategy, such as of a set of counterparties. The intelligent services system 2143 may receive data from various sources and may generate a set of feature vectors based on the received data. The intelligent services system 2143 may input the set of feature vectors into a machine-learned model trained to detect the trading strategy and to generate an output that classifies the trading strategy. In embodiments, the model may be trained on a training data set wherein expert traders classify trading strategies based on the data sources and/or upon outcomes (such as outcomes of counterstrategies that were selected based on the classifications and/or upon outcomes where one or more parties validated the accuracy of the classification). In embodiments, the model may be generated by deep learning. In embodiments, the model may be supervised, unsupervised, or semi-supervised. In embodiments, the model may use a recurrent neural network, optionally a gated recurrent neural network that provides improved performance as a result of placing diminishing weight on aging data and that mitigates compounding error problems. In embodiments, the model may employ a convolutional neural network (alone or in combination with another type of neural network, such as a recurrent neural network), such as where images of trading patterns (e.g., price patterns, volatility patterns, volume patterns and the like) are provided as input data sources to the model. Once a trading strategy is classified, a further machine-learned model as previously described may generate an appropriate trading strategy that is a suitable counterstrategy to the detected strategy.

In yet other examples, a set of machine-learned models may be used to select a trading strategy from a set of trading strategies, including any of the strategies described herein and/or in the documents incorporated herein by reference. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to select a trading strategy from a set of trading strategies, such as based on a training data set of outcomes. In embodiments, the intelligent services system 2143 may include an input set of training data representing decision support related to selecting trading strategies by a set of human experts and/or by other systems or models. Selection of a trading strategy may be trained on outcomes, including by use of various metrics that indicate trading strategy performance, optionally including risk-adjusted strategy performance, such as Sharpe ratios, multiples on invested capital, investment rates of return (IRRs), cost-adjusted return metrics, benchmark comparisons (e.g., benchmarking against an index fund), and many others. Data sources and feature vectors used for management may include marketplace data of the many types described herein as well as external data sources that may assist with prediction of trading behavior and marketplace patterns.

In yet other examples, a set of machine-learned models may be used to manage a trading strategy, including any of the strategies described herein and/or in the documents incorporated herein by reference. For example, the intelligent services system 2143 may receive data from various sources described throughout this document and the documents incorporated by reference herein and may generate a set of feature vectors based on the received data. The intelligent services system 2143 may input the set of feature vectors into a machine-learned model that is trained (e.g., using a combination of simulation data and real-world data) to manage the trading strategy. The model performing management of the trading strategy may be trained based on a training set of management decisions by a set of experts that manage the strategies, and in embodiments, may employ robotic process automation by training on a set of inputs by experts in a management interface that manages the trading strategy. The model may be a deep learning model, a supervised model, an unsupervised model and/or a semi-supervised model and may employ any of the artificial intelligence techniques and systems described herein and/or in the documents incorporated by reference. In embodiments, the management model is trained on outcomes/feedback, such as one or more performance metrics described herein, such as a Sharpe ratio or other metric of model performance. Data sources and feature vectors used for management may include marketplace data of the many types described herein as well as external data sources that may assist with prediction of trading behavior and marketplace patterns. A strategy management model may be configured to implement a set of rules or policies, such as ones that require halting of trading in extreme circumstances, ones that shift to alternate strategies based on contextual or market conditions, or the like. For example, a set of rules may provide for a primary strategy and a set of contingent strategies that are triggered upon determination of a set of triggers, whereby the management model automatically shifts to the contingent strategy upon detection of the trigger. For example, a buy and hold strategy may be configured to shift to an active trading (e.g., selling, or shorting) strategy upon detection that the aggregate price/earnings ratio of a marketplace exceeds a defined value (such as suggesting that the entire asset class is overvalued). As another example, a day trading strategy may be configured to shift automatically to a long/short strategy if in-session price volatility is detected to be below a defined threshold metric, implying that day trading is unlikely to be profitable on a cost- and risk-adjusted basis due to trading costs. In embodiments, a set of trading strategies may be structured in a hierarchy, a flow diagram, a graph (optionally a directed acyclic graph), or the like, which may be configured in a data schema (optionally stored in a graph database or similar data resource) that can be parsed by the machine-learned strategy management model to determine a sequence of trading strategies in response to determination of triggers. In embodiments, the data schema capturing the set of trading strategies may include triggers (states, conditions, thresholds, and the like) for triggering shifts in trading strategy, as well as the rules, configuration parameters, and other data and metadata needed to configure the model for management of each strategy or set or set of strategies.

In examples, a set of machine-learned models may be used to categorize or classify traders. For example, the intelligent services system 2143 may receive data from various sources described throughout this document and the documents incorporated by reference herein and may generate a set of feature vectors based on the received data. The intelligent services system 2143 may input the set of feature vectors into a machine-learned model trained (e.g., using a combination of simulation data and real-world data) to categorize traders, such as based on a training data set of outcomes. In embodiments, the intelligent services system 2143 may include an input set of training data representing categorizations or classifications of traders by a set of human experts and/or by other systems or models. Data sources and feature vectors used for categorization or classification of traders may include marketplace data of the many types described herein, trader profile data, as well as external data sources (such as from social media content originating from or relating to traders or discussion board content originating from or relating to traders) that may assist with classification or categorization of traders. Such artificial intelligence systems used for classification, in the present example and other examples described herein, may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In yet other examples, a set of machine-learned models may be used to classify or categorize assets. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to categorize assets, such as based on a training data set of outcomes. In embodiments, the intelligent services system 2143 may include an input set of training data representing categorizations or classifications of assets by a set of human experts and/or by other systems or models. Data sources and feature vectors used for categorization or classification of assets may include from historical asset performance data, including pricing data, profitability data, operational data, product or service performance data, liability data, data indicative of failure rates (e.g., product faults, service failures, delivery failures, and many others), party performance data, market data (e.g., price trends, volatility, and others), asset data (including asset descriptions, asset profiles, content associated with assets (including images, video, and audio)), as well as external data sources (such as from websites related to assets) that may assist with classification or categorization of assets, and many others.

In examples, a set of machine-learned models may be used to automatically configure a marketplace. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to automatically configure a marketplace, such as based on a training data set of outcomes. In embodiments, the intelligent services system 2143 may include an input set of training data representing marketplace configurations by a set of human experts and/or by other systems or models. Data sources and feature vectors used for configuration of marketplaces may include asset data (optionally including asset demand data, supply data, cost data, volatility data, pricing pattern data, trade size data, trade volume data, geographic trading data, trading party profile data, and/or many other types of asset-related data), marketplace profitability data, marketplace efficiency data, latency data, as well as external data sources (such as from laws or regulations) that may assist with marketplace configuration. Such artificial intelligence systems used for configuration, in the present example and other examples described herein, may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to optimize marketplace efficiency. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to optimize the efficiency of a marketplace, such as based on a training data set of outcomes. In embodiments, the intelligent services system 2143 may include an input set of training data representing marketplace efficiency optimization by a set of human experts and/or by other systems or models. Data sources and feature vectors used for optimization of marketplace efficiency may include marketplace data of the many types described herein (optionally including transaction matching speed data) that may assist with marketplace efficiency optimization. Such artificial intelligence systems used for optimization, in the present example and other examples described herein, may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to optimize marketplace profitability. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to optimize the profitability of the marketplace, such as based on a training data set of outcomes. In embodiments, the intelligent services system 2143 may include an input set of training data representing marketplace profitability optimization by a set of human experts and/or by other systems or models. Data sources and feature vectors used for optimization of marketplace profitability may include marketplace data of the many types described herein (optionally including trading data, commission data, or fees data) that may assist with marketplace profitability optimization.

In yet other examples, a set of machine-learned models may be used to automate trading activities. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to automate trading activities, such as based on a training data set of outcomes. In embodiments, the intelligent services system 2143 may include an input set of training data representing trading activities by a set of human experts and/or by other systems or models. Data sources used to produce the set of feature vectors, may include, but are not limited to, asset data (optionally including asset demand data, supply data, cost data, volatility data, pricing pattern data, trade size data, trade volume data, geographic trading data, trading party profile data, and/or many other types of asset-related data), discussion boards (such as involving chats, comment threads involving assets, or the like), social media sites (such as involving posts or threads involving assets or the like), external (such as news involving assets or the like), and others. Such artificial intelligence systems used for automation, in the present example and other examples described herein, may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to determine a counterparty's willingness to trade. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to determine a counterparty's willingness to enter a trade, such as based on a training data set of outcomes. In embodiments, the intelligent services system 2143 may include an input set of training data representing willingness to trade by a set of human experts and/or by other systems or models. Data sources and feature vectors used for determining a counterparty's willingness to trade may include trader profile data, historical trading data for the trader, external data (such as social media data or discussion board data relating to the trader/counterparty), or marketplace data of the many types described herein that may assist with determining a counterparty's willingness to enter a trade.

In examples, a set of machine-learned models may be used to generate a fairness score for a trade. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to generate a fairness score for a trade, such as based on a training data set of outcomes. In embodiments, the intelligent services system 2143 may include an input set of training data representing fairness scores by a set of human experts and/or by other systems or models. Data sources and feature vectors used in generating a fairness score may include trader data, marketplace participant device location data, latency data, historical trading data, or marketplace data of the many types described herein that may assist with generating a fairness score. Such artificial intelligence systems used for generation (such as the generation of scores or generation of content), in the present example and other examples described herein, may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to calculate the financial advantage that a trader would have experienced had he or she been trading with less latency. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to calculate the financial advantage that a trader would have experienced had he or she been experiencing less latency, such as based on a training data set of outcomes. In embodiments, the intelligent services system 2143 may include an input set of training data representing financial advantage calculations by a set of human experts and/or by other systems or models. Data sources and feature vectors used for calculating a financial advantage may include trader data, marketplace participant device location data, latency data, or marketplace data of the many types described herein that may assist with calculating a financial advantage that a trader would have experienced had he or she been experiencing less latency. Such artificial intelligence systems used for calculation, in the present example and other examples described herein, may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to determine the risk tolerance of a trader. For example, the intelligent services system 2143 may receive data from various sources described throughout this document and the documents incorporated by reference herein and may generate a set of feature vectors based on the received data. The intelligent services system 2143 may input the feature vectors into machine-learned models trained (e.g., using a combination of simulation data and real-world data) to determine the risk tolerance of a trader. In embodiments, the intelligent services system 2143 may include an input set of training data representing trader risk tolerance by a set of human experts and/or by other systems or models. Data sources and feature vectors used for determining the risk tolerance of a trader may include trader profile data, historical trading data for the trader, external (including social media content related to the trader), or marketplace data of the many types described herein that may assist with determining the risk tolerance of a trader.

The foregoing examples are non-limiting examples and the intelligent services system 2143 may be used for any other suitable AI/machine-learning related tasks that are performed with respect to industrial facilities.

In embodiments, the platform 2400 includes an intelligent matching system 2130 for performing AI-driven order matching. In embodiments, intelligent matching system 2130 may leverage order matching algorithms. In embodiments, order matching algorithms may include, but are not limited to, allocation, FIFO, FIFO with LMM, FIFO with top order and LMM, pro-rata, configurable, threshold pro-rata, and threshold pro-rata with LMM algorithms.

In embodiments, the platform 2400 includes a fairness engine 2168 that monitors the execution engine 2128 and calculates the fairness of a transaction. In embodiments, the fairness calculation may be used to adjust the operation of the intelligent matching system 2130 such that the intelligent matching system 2130 optimizes the fairness of future trades.

In embodiments, the fairness calculation may be used to generate individual fairness scores for traders. In some embodiments, the fairness score may be an accumulated score that has value and can be traded as a part of the overall system. For example, a market participant (e.g., a trader) may have a negative trading fairness score and may trade to increase his or her trading fairness score. In embodiments, the fairness score may be based on the time of placement (rather than the time of receipt) of a bid or ask. In embodiments, the fairness engine 2168 may be configured to calculate the advantage (such as in dollars or other measures) that the trader would have experienced had he or she been trading with less latency. In some embodiments, the Local Market Maker (LMM) trades may decrease the quality of the trade (e.g., by increasing the price). In embodiments, the fairness may be based on or include a measure of the value of the disadvantage to the trader, wherein the value accumulates over time and the intelligent matching system 2130 works to reduce the value of the fairness disadvantage with future advantageous trades.

In embodiments, a fairness engine may include an execution timing fairness engine that may determine or receive a set of measures of latency for a set of users, such as traders, and may automatically orchestrate a set of configuration parameters or other features that mitigate unfairness that may be caused by disparate latency (such as unfairness resulting from front-running, rapid execution of trades based on emerging information, and the like). In embodiments, latency may result from a number of factors, including processing performance of edge computational network devices, the network path through which a set of data packets travels, the network protocol used to transport data packets, the type and physical characteristics (e.g., length of fiber optic wire) of physical layer used to transport data packets, the number of coupling nodes present in the data path, the performance of databases and other data repositories (e.g., input/output performance), and the computational performance of systems used to execute algorithms that determine actions, such as trades. In embodiments, latency may be determined by testing network return times, such as by determining the ping, the upload speed, the download speed, or the like, such as using publicly available systems for testing those parameters. In other embodiments, latency may be determined by testing responsiveness of systems to a set of stimuli, such as by observing the response of a system (such as an algorithmic trading system) to a set of stimuli, e.g., observing how quickly the system executes a trade in response to an event, such as a bid/ask event, a news event, or the like. In embodiments, the fairness engine may detect the use of a quantum computation system, a quantum algorithm, or the like and may adjust execution to account for the advantages of quantum computation or quantum algorithmic execution. This may include providing a set of stimuli that is capable of solution only by quantum computational or algorithmic techniques and detecting responses from identified trading systems. In embodiments, detection may include detection of trading behavior that includes evidence of utilization of entangled states, such as involving simultaneously executed trades across different marketplaces that may be governed by the platform 2400.

In embodiments, configuration or orchestration may include any set of techniques that are designed to mitigate advantages in latency that result from any of the foregoing causes of latency. For example, in embodiments, configuration or orchestration may include grouping traders into cohorts that experience similar latency, such that trades are executed only among members of a cohort. Configuration or orchestration may include automatically imposing a delay on low-latency instructions, such as to cause such instructions to be executed with average latency, with a minimum threshold latency, or the like. Configuration or orchestration may include deploying computational or network resources that improve latency for high-latency users, such as by using network coding technologies (e.g., random linear network coding, polar coding, and the like), path-based routing technologies, caching technologies, load balancing technologies, and the like to diminish latency, such as to an average level of latency, a minimum threshold level of latency, or the like. Configuration or orchestration may include applying incentives and/or penalties, such as by imposing additional trading costs on low-latency traders and/or rewards or incentives for high-latency traders. Incentives or penalties may, in embodiments, be accumulated in fiat currency, in a cryptocurrency, and/or in a token, such as a marketplace-specific token, such as where tokens accumulated as a result of a fairness disadvantage may be traded for value in the marketplace. In embodiments, configuration parameters may be based on an average latency across a cohort of users and may apply to diminish or eliminate disadvantages to a subset of users that experience latency within a defined difference from the average, such as not more than 25% more latency, not more than 50% more latency, not more than 75% more latency, not more than double latency, not more than triple latency, or the like. Setting a limit on the applicability of the fairness engine may avoid or mitigate users intentionally using low-performance systems to acquire advantages in the system. Configuration or orchestration may include setting parameters to eliminate fairness disadvantages entirely, or it may include setting parameters to mitigate fairness disadvantages to an extent, while still allowing faster systems to experience some advantage.

In embodiments, an execution fairness timing engine may be employed in other areas, such as to ensure fair execution among players in online games or other environments where users compete to undertake actions and outcomes depend on the relative timing of the actions.

In embodiments, the platform 2400 may include a loyalty system 2170 for monitoring the data generator in the execution engine 2128 to determine when non-cancelled orders are placed. In embodiments, the loyalty system 2170 allows volume amounts for trading to grow as a party's presence in the market increases. In embodiments, the loyalty system 2170 allows points to be accumulated as trades are made. In these embodiments, the point accumulation may be made at a delay (such as a one-minute delay, a five-minute delay, a ten-minute delay, a one-hour delay, or the like), such as to allow for efficient application construction. In embodiments, the overall value of the trades made are captured and points may be calculated based on metrics such as total volume, total value to the market, and the like. The matching algorithms of the intelligent matching system 2130 may be adjusted to provide more favorable outcomes based on the loyalty level of the trader. In addition, new traders to a marketplace may request higher loyalty status based on moving their existing business to the new marketplace. Points may be embodied in tokens, such as cryptographically secure tokens, which, in embodiments, may be tradeable for value in the market, or the like.

In embodiments, the platform 2400 may include a latency factor module 2139 for calculating a user's latency. This latency factor may be received by the intelligent matching system 2130 to provide a more balanced trading position for more remote traders.

In embodiments, the intelligent matching system 2130 may enable users to place trades using secret algorithms. In embodiments, a trader may provide a time window for the trade and an associated secret algorithm via a GUI provided by the platform 2400. For example, a user may input a second peak price or price over 48.100. Continuing the example, the intelligent matching system 2130 would only publish the first price 48.100 and then the bid or ask will adjust the price based on the associated secret algorithm. As this algorithm is executing on the trading system, the geographic advantage is removed. As the behavior is multi-faceted, other traders cannot tell what they expect the bid or ask to do in response to market trades.

In some embodiments, the intelligent matching system 2130 is configured to support quantum order matching. Quantum order matching may allow users, such as counterparties, to coordinate activities, such as simultaneous buy or sell activity that happens in geographically distributed markets. This allows for parties to have identical (but unknown to each other) positions that can then be used as part of a sophisticated mechanism to manage the risk of a portfolio. In embodiments, the quantum computing system 2114 has entangled states with other quantum computing systems. These entangled states may be resolved to a known state at a predetermined point in time, which may be used to determine the outcome of a trading action. These positions are then considered to be coordinated remotely. This allows simultaneously larger positions to be moved (e.g., by bidding, asking, buying, selling, or the like) in multiple locations without the individual markets being forewarned of the overall change in position.

In some embodiments, the platform 2400 includes a deterministic state execution machine. A sequence of selling and buying may be built around deterministic state execution machine. This deterministic state execution machine may provide the same output given an identical input. The deterministic process allows for parallel market execution and trade determination processes (including cancellations) to provide for linear scaling of intelligent matching. In embodiments, the intelligent matching system 2130 reads order data (such as from an order book) in an organized and deterministic way. By following a deterministic process using systems like finite state machines, simple allocation engines, or other non-random processes, the execution process can always be run in parallel, allowing for multiple matching engines to exist and handle redundancy and parallelism.

In embodiments, the platform 2400 includes a state machine. In embodiments, the state of a marketplace is held in this state machine, which may be subject to deterministic and nondeterministic state processes. This allows for the management of a complex number of factors in trade execution (such as loyalty and random outcomes). The overall state transition process is logged to allow for audit of the process so that regulators can always determine why an outcome happened.

In embodiments, the platform 2400 includes a cancel order engine for receiving and processing cancelled orders. In embodiments, cancelled orders may be processed by the execution engine 2128. In embodiments, the platform 2400 includes a passive matching engine. In embodiments, the passive matching engine may be configured to identify messages submitted by the marketplace participant user devices 2118 and run identical state machine and identical code of the primary engine as backup to the intelligent matching system 2130. In embodiments, machine learning and/or AI algorithms may be leveraged to generate a decision of which matching engine to use. In embodiments, the platform includes an order book, which may refer to the list of orders that a marketplace uses to record offers to buy and sell assets.

In embodiments, the quantum computing system 2114 may support many different quantum models, including, but not limited to, the quantum circuit model, quantum Turing machine, adiabatic quantum computer, one-way quantum computer, quantum annealing, and various quantum cellular automata. Under the quantum circuit model, quantum circuits may be based on the quantum bit, or “qubit”, which is somewhat analogous to the bit in classical computation. Qubits may be in a 1 or 0 quantum state, or they may be in a superposition of the 1 and 0 states. However, when qubits have measured the result of a measurement, qubits will always be in either a 1 or 0 quantum state. The probabilities related to these two outcomes depend on the quantum state that the qubits were in immediately before the measurement. Computation is performed by manipulating qubits with quantum logic gates, which are somewhat analogous to classical logic gates.

In embodiments, the quantum computing system 2114 may be physically implemented using an analog approach or a digital approach. Analog approaches may include, but are not limited to, quantum simulation, quantum annealing, and adiabatic quantum computation. In embodiments, digital quantum computers use quantum logic gates for computation. Both analog and digital approaches may use quantum bits or qubits.

A market orchestration process executed by the platform 2400 may be a process whereby an asset (such as a product, service, or the like) is introduced into a tradable form. In traditional market embodiments, assets may refer to bonds, stocks, cash, and the like, including any of the wide variety described herein and/or in the documents incorporated herein by reference. In non-traditional market embodiments, assets may refer to 3D printed products, 3D printing instructions and other instruction sets, resources (such as energy, computation, storage, or the like), attention or other user behavior, services (such as computer programming services, microservices, process automation services, artificial intelligence services, and many others), and the like, including the many other examples described herein and/or in the documents incorporated herein by reference. In embodiments, the market orchestration processes using quantum optimization via the quantum computing system 2114 may apply equally to traditional and non-traditional asset marketplaces. Furthermore, embodiments may combine non-traditional assets and traditional assets in order to extend traditional markets into non-traditional and hybrid market modules.

In embodiments, the quantum computing system 2114 includes a quantum annealing module 2103 wherein the quantum annealing module may be configured to find the global minimum or maximum of a given objective function over a given set of candidate solutions (e.g., candidate states) using quantum fluctuations. As used herein, quantum annealing may refer to a meta-procedure for finding a procedure that identifies an absolute minimum or maximum, such as a size, length, cost, time, distance, or other measures, from within a possibly very large, but finite, set of possible solutions using quantum fluctuation-based computation instead of classical computation. The quantum annealing module 2103 may be leveraged for problems where the search space is discrete (e.g., combinatorial optimization problems) with many local minima, such as finding the ground state of a spin glass or the traveling salesman problem.

In embodiments, the quantum annealing module 2103 starts from a quantum-mechanical superposition of all possible states (candidate states) with equal weights. The quantum annealing module 2103 may then evolve, such as following the time-dependent Schrödinger equation, a natural quantum-mechanical evolution of systems (e.g., physical systems, logical systems, or the like). In embodiments, the amplitudes of all candidate states change, realizing quantum parallelism according to the time-dependent strength of the transverse field, which causes quantum tunneling between states. If the rate of change of the transverse field is slow enough, the quantum annealing module 2103 may stay close to the ground state of the instantaneous Hamiltonian. If the rate of change of the transverse field is accelerated, the quantum annealing module 2103 may leave the ground state temporarily but produce a higher likelihood of concluding in the ground state of the final problem energy state or Hamiltonian.

In some implementations, the quantum computing system 2114 includes a trapped ion quantum computer module 2105, which may be a quantum computer that applies trapped ions to solve complex problems. Trapped ion quantum computer module 2105 may have low quantum decoherence and may be able to construct large solution states. Ions, or charged atomic particles, may be confined, and suspended in free space using electromagnetic fields. Qubits are stored in stable electronic states of each ion, and quantum information may be transferred through the collective quantized motion of the ions in a shared trap (interacting through the Coulomb force). Lasers may be applied to induce coupling between the qubit states (for single-qubit operations) or coupling between the internal qubit states and the external motional states (for entanglement between qubits).

In embodiments, the quantum computing system 2114 may include arbitrarily large numbers of qubits and may transport ions to spatially distinct locations in an array of ion traps, building large, entangled states via photonically connected networks of remotely entangled ion chains.

In embodiments, a traditional computer, including a processor, memory, and a graphical user interface (GUI), may be used for designing, compiling, and providing output from the execution, and the quantum computing system 2114 may be used for executing the machine language instructions. In embodiments, the quantum computing system 2114 may be simulated by a computer program executed by the traditional computer. In such embodiments, a superposition of states of the quantum computing system 2114 can be prepared based on input from the initial conditions. Since the initialization operation available in a quantum computer can only initialize a qubit to either the |0> or |1> state, initialization to a superposition of states is physically unrealistic. For simulation purposes, however, it may be useful to bypass the initialization process and initialize the quantum computing system 2114 directly.

According to embodiments herein, the quantum computing system 2114 may perform quantum trading orchestration, which may be configured to optimize difficult-to-correlate, related cross-chain and cross-channel interactions that, when added together through the use of quantum computing, make up an individualized marketplace experience.

In embodiments, the quantum computing system 2114 may include quantum input filters 2109. In embodiments, quantum input filters 2109 may be configured to select whether to run a model on the quantum computing system 2114 or to run the model on a classic computing system. In some embodiments, quantum input filters 2109 may filter data for later modeling on a classic computer. Typically, cross-market platform interactions are interactions across multiple market platforms. In a dynamic market orchestration trading atmosphere, service providers and market platforms must be able to engage with agents on all levels, from varying delivery devices to varying platforms, both traditional and innovative. Engagement may need to be delivered in real-time, with genuine transparency and individualized responses. In embodiments, the quantum computing system 2114 may become an integral part of this interaction and allow for the service providers to connect with market platforms in an optimized and efficient way. In embodiments, the quantum computing system 2114 may provide input to traditional compute platforms while filtering out unnecessary information from flowing into distributed platform systems. In some embodiments, the platform 2400 may trust through filtered specified experiences for intelligent agents.

Quantum computers are commercially available, but they remain expensive and limited in capacity, and quantum algorithms are available only for a subset of the host of problems to which they may be applied. Accordingly, the advantages of use of quantum computation within the platform 2400 (the benefits relative to the costs) are likely to be episodic. In embodiments, a platform for marketplace orchestration system platform 2400 or other platforms may include model or system for automatically determining, based on a set of inputs, whether to deploy quantum computational or quantum algorithmic resources to a marketplace activity (such as trade configuration), whether to deploy traditional computational resources and algorithms, or whether to apply a hybrid or combination of them. In embodiments, inputs to a model or automation system may include trading patterns, energy cost information, capital costs for computational resources, development costs (such as for algorithms), operational costs (including labor and other costs), performance information on available resources (quantum and traditional), market price and volume information, market volatility, and any of the many other data sets that may be used to simulate (such as using any of a wide variety of simulation techniques described herein and/or in the documents incorporated herein by reference) and/or predict the difference in outcome between a quantum-optimized result and a non-quantum-optimized result from a trading strategy. A machine learned model may be trained, such as by deep learning on outcomes or by a data set from human expert decisions, to determine what set of resources to deploy given the input data for a given marketplace. The model may itself be deployed on quantum computational resources and/or may use quantum algorithms, such as quantum annealing, to determine whether, where, and when to use quantum systems, conventional systems, and/or hybrids or combinations.

In embodiments, the quantum computing system 2114 includes quantum output filters 2111. In embodiments, quantum output filters 2111 may be configured to select a solution from solutions of multiple neural networks. For example, multiple neural networks may be configured to generate solutions to a specific problem (such as the optimal trading strategy within a marketplace and/or across a set of marketplaces, given a set of input data), and the quantum output filter 2111 may select the best solution from the set of solutions.

In some embodiments, the quantum computing system 2114 connects and directs a neural network development or selection process. In this embodiment, the quantum computing system 2114 may directly program the weights of a neural network such that the neural network gives the desired outputs. This quantum-programmed neural network may then operate without the oversight of the quantum computing system 2114, but will still be operating within the expected parameters of the desired computational engine.

In embodiments, the quantum computing system 2114 includes a quantum database engine 2113. In embodiments, quantum database engine 2113 may assist with the recognition of individuals and identities across market platforms by establishing a single identity that is valid across interactions and touchpoints. Aligning to a trader's transaction path, this “stitching” together of cross-device and market platform entities may facilitate building a strong underlying dataset. The quantum database engine 2113 may be configured to perform optimization of data matching and intelligent traditional compute optimization to match individual data elements between roles. Matching may be used to establish an identity of a counterparty, such as by matching patterns of trading, such as based on various data inputs, including trade types, timing, geolocation, and the like, among many others.

A quantum rules-based predictive transaction path selection may be based on having granular, agent-level interaction and behavioral data. That knowledge, which may come from internal systems as well as third-party data sources, may be made actionable through automated triggers set up to respond to specific buyer actions. These individual triggers and levels may be monitored and optimized through the application of quantum optimization engines that can oversee the entire process.

The quantum computing system 2114 may include, but is not limited to, analog quantum computers, digital computers, and/or error-corrected quantum computers. Analog quantum computers may directly manipulate the interactions between qubits without breaking these actions into primitive gate operations. In embodiments, quantum computers that may run analog machines include, but are not limited to, quantum annealers, adiabatic quantum computers, and direct quantum simulators. The digital computers may operate by carrying out an algorithm of interest using primitive gate operations on physical qubits. Error-corrected quantum computers may refer to a version of gate-based quantum computers made more robust through the deployment of quantum error correction (QEC), which enables noisy physical qubits to emulate stable logical qubits so that the computer behaves reliably for any computation. Further, quantum information products may include, but are not limited to, computing power, quantum predictions, and quantum inventions.

In embodiments, the platform 2400 facilitates one or more intelligent agents 2134 to perform research on electronic marketplace assets, shop and/or scan in different markets, compare marketplaces and assets, discuss assets and market benefits, engage proactively in the facilitation of markets, ask questions, read reviews, and weave through a variety of mediums and paths before initiating facilitation of a marketplace. In some embodiments, the intelligent agents 2134 may be automated systems that are engaged in the process of building an electronic marketplace. In embodiments, intelligent agents 2134 may be configured to identify marketplaces that may benefit from merging because of similar assets, similar configuration parameters 2206, similar rules, similar traders, and the like. In embodiments, intelligent agents 2134 may be configured to merge the identified marketplaces. In some embodiments, intelligent agents 2134 may be configured to identify marketplaces that may benefit from splitting into multiple marketplaces. In some embodiments, intelligent agents 2134 may be configured to split the identified marketplace(s). In embodiments, the quantum computing system 2114 may be configured to allow selected data streams to come together and produce optimized directions to the automated marketplace process.

In some embodiments, the quantum computing system 2114 is configured as an engine that may be used to optimize traditional computers, minimize the cost of trade in the marketplace, identify and set up systems to act on arbitrage opportunities, and/or combine data from multiple sources into a decision-making process.

The data gathered in the process of the market orchestration may involve real-time capture and management of interaction data by a wide range of tracking capabilities, both directly associated with transactions and indirectly related to transactions. In embodiments, the quantum computing system 2114 may be configured to accept cookies, email addresses, and other contact data, social media feeds, news feeds, event and transaction log data (including transaction events, network events, computational events, and many others), event streams, results of web crawling, distributed ledger information (including blockchain updates and state information), results from distributed or federated queries of data sources, streams of data from chat rooms and discussion forums, and many others.

In embodiments, the quantum computing system 2114 includes a quantum register 2115 having a plurality of qubits. Further, the quantum computing system 2114 may include a quantum control system 2119 for implementing the fundamental operations on each of the qubits in the quantum register and a control processor for coordinating the operations required.

In embodiments, the quantum computing system 2114 is configured to optimize a marketplace and/or pricing of assets in a marketplace. In an aspect, the quantum computing system 2114 is configured to solve very largely arbitrage-related optimization problems across marketplaces. For example, the quantum computing system 2114 may solve the ideal asset pricing across marketplaces. In embodiments, the quantum computing system 2114 may utilize quantum annealing to provide optimized asset pricing. In embodiments, the quantum computing system 2114 may use q-bit based computational methods to optimize asset pricing. In some embodiments, the quantum computing system 2114 is configured to solve arbitrage-related optimization problems across marketplaces.

In embodiments, the quantum computing system 2114 and/or artificial intelligence system of the platform 2400 may be used to determine a rate of exchange between, among, or across a set of marketplaces, including ones that trade in different fiat currencies, cryptocurrencies, tokens, in-kind value (e.g., exchanges of services), or other units of exchange, such as by simulating a set of trading activities involving the set of marketplaces. For example, an exchange rate may be determined between a renewable energy credit marketplace and a cryptocurrency marketplace (e.g., for Bitcoin™), between a pollution credit marketplace and an advertising marketplace, between a stock market and a bond market, between different fiat currencies, between various fiat and cryptocurrencies, between an advertising marketplace and a loyalty marketplace, and the like, optionally including any pair or other combination of any of the types of marketplace described herein and/or in the documents incorporated by reference herein. Determining an optimal exchange range may allow a market orchestrator to adjust an exchange rate to make it closer to optimal and/or it may be used to identify arbitrage opportunities and/or currency trading opportunities that arise from sub-optimal exchange rates being offered in the marketplace(s).

In embodiments, the quantum computing system 2114 is configured to optimize a portfolio. A quantum-enhanced portfolio optimization may include building a portfolio of assets to yield the maximum possible return while minimizing the amount of risk or maintaining a risk tolerance. Quantum enhancement may provide more precise methods of optimizations where the risk/reward balance is calculated inside the quantum computing system 2114. In embodiments, the quantum computing system 2114 invests in a wide variety of asset types and classes to provide the appropriate level of diversification of the portfolio. In embodiments, quantum enhancement is undertaken with awareness of volatility, and in particular volatility that may emerge from chaotic behavior of relevant marketplace entities (such as where behavior of the entities is highly sensitive to initial conditions), such that optimization is applied (optionally automatically) to situations where an optimal solution is less likely to devolve rapidly to a sub-optimal behavior as a results of chaotic behavior. For example, quantum enhancement may be more effective to optimize strategies involving very large numbers of interactions of entities that change relatively slowly, rather than interactions among very rapidly changing entities, where slight errors in measurement of initial conditions may rapidly propagate. In embodiments, models of trading strategies, arbitrage strategies, exchange rate optimization, and many others may include error estimation factors based on an understanding of sensitivity to initial conditions, chaotic/fractal behavior of entities, and the like, which may include an error detection and sensitivity estimation engine configured to estimate and/or simulate the sensitivity of a quantum optimized model or other model described herein to potential errors in state information or other information used to populate the model.

In embodiments, the use of the quantum computing system 2114 to determine asset classes for investment is a risk-mitigation strategy. Asset classes may include types of securities, debt and equities, and the like (as with other examples throughout this disclosure, except where context indicates otherwise, mentions of asset classes throughout this disclosure may refer to any of the types described herein and/or in the documents incorporated by reference herein), and each asset class may have quite different return and risk characteristics. In embodiments, vastly different types of asset classes may be combined together to provide an efficient portfolio. By way of example, a quantum optimization may include a mixture of commodities, equities, cryptocurrencies, bonds, and other assets, such as including various pairs and combinations that are mutually countercyclical in nature in order to mitigate overall risk.

In embodiments, the quantum computing system 2114 or other systems of the platform 2400 may spread its investment across asset classes, including a mixture of traditional assets and non-traditional assets. In embodiments, traditional assets may include, but are not limited to, bonds, income-generating bonds, stocks, commodities, contracts, cash, and cash equivalents, and cybercurrency. In embodiments, non-traditional assets may include, but are not limited to, three-dimensional printed product markets, private company funding facilities, trade services, and programming services.

In some embodiments, the quantum computing system 2114 or other systems of the platform 2400 may be configured to provide a marketplace that trades on the bond and commodities markets and exposes the buyers and sellers to a higher-level security and that has a risk profile similar to a mutual fund.

In some embodiments, the quantum computing system 2114 or other systems of the platform 2400 may be configured to predict volatility in assets and/or markets, enabling a lower risk profile for investment strategies. In embodiments, the quantum computing system 2114 or other systems of the platform 2400 may be applied to manage defined risk factors, providing markets where buyers and sellers are operating at higher or lower levels of risk.

In some embodiments of the present invention, the quantum computing system 2114 or other systems of the platform 2400 may assign an optimization weight for each asset class (and all assets within each class) traded in a marketplace. In embodiments, the weight may be defined as the percentage of the portfolio that concentrates within any particular class. For example, the quantum computing system 2114 or other systems of the platform 2400 may apply a 10% weight to stocks and a 20% weight to bonds. This weighting results in bonds being twice as important as stocks in the portfolio. In examples, the quantum computing system 2114 or other systems of the platform 2400 may assign sub-weights to slow-growth stocks and fast-growth stocks at 20% and 10%, respectively. The implementation of the quantum computing system 2114 or other systems of the platform 2400 with associated classical computing systems may enable the continuing maintenance of these asset weights. In embodiments, the quantum computing system 2114 or other systems of the platform 2400 may be configured to adjust the weights to produce the desired risk profile for the overall portfolio.

According to embodiments herein, the user may assign asset weights based upon his/her risk and return tolerance. If the user hopes to minimize the risk, he or she would assign greater weight to low-risk, low-growth assets. In the example above, the quantum computing system 2114 or other systems of the platform 2400 has performed the similar procedure by assigning twice as much weight to safe investments as profitable ones.

In some implementations, the quantum computing system 2114 or other systems of the platform 2400 may perform a plurality of specific assessments, such as determining the investment goals of a trader, the risk tolerance of the trader, and the like. Upon performing the specific assessments, the quantum computing system 2114 or other systems of the platform 2400 may assign weights to different asset classes to maintain the balance between the risk and return preferences. The quantum computing system 2114 or other systems of the platform 2400 may seek an efficient frontier, which may refer to a maximum amount an investment can earn given its established risk level.

For example, if the quantum computing system 2114 or other systems of the platform 2400 determines that a 20% risk of loss is the trader's risk tolerance, the quantum computing system 2114 or other systems of the platform 2400 will build a portfolio that can make the most money possible without exceeding that risk threshold. Continuing the example, the quantum computing system 2114 or other systems of the platform 2400 may select the following assets for its portfolio based on each one's promised returns: Bond ABC (risk 10%), Stock XYZ (risk 50%), and Stock TUV (risk 30%).

In embodiments, the quantum computing system 2114 includes a quantum computation module 2121 to calculate the weights. Typically, in a non-optimized portfolio, the users might place too much money in Bond ABC, thus reducing the possible returns, or over-invest in Stock XYZ, which would create too much risk. So, the quantum computation module 2121 calculates exactly how much of each stock is required for the user.

While a traditional computation module cannot solve the equations below due to high number of permutations of options, the quantum computing system 2114 may make an investment decision based on meeting desired end use parameters.

$$Weight ( ABC ) + Weight ( XYZ ) + Weight ( TUV ) = 1 \qquad ( Equation 1 )$$

$$\text{.1} * Weight ( ABC ) + 0.5 * Weight ( XYZ ) + 0.3 * Weight ( TUV ) = 0.2 \qquad ( Equation 2 )$$

In some embodiments, the quantum computing system 2114 or other systems of the platform 2400 is configured to select transactions to build a desired position in a particular market. The quantum computing system 2114 or other systems of the platform 2400 may build a desired position in the market by evaluating possible transactions and factoring consequences of each transaction.

In embodiments, the quantum computing system 2114 or other systems of the platform 2400 utilize a pyramiding method of increasing margin by using unrealized returns from successful trades. The pyramiding method may refer to only adding to positions that are turning a profit and showing signals of continued strength. These signals could be continued as asset prices reach to new highs or the asset prices retreat to previous lows. The pyramiding method takes advantage of trends, adding to the user's position size with each wave of that trend. Further, the quantum-enabled pyramiding method is also beneficial in that risk (in terms of maximum loss) does not have to increase by adding to a profitable existing position. Original and previous additions will all show profit before a new addition is made, which means that any potential losses on newer positions are offset by earlier entries.

In embodiments, the quantum computing system 2114 or other systems of the platform 2400 are configured to generate a ranked list of assets. In embodiments, the quantum computing system 2114 or other systems of the platform 2400 may utilize a factor investing approach that involves targeting quantifiable factors that can explain differences in asset returns. In a long-only portfolio, a systematic factor investing strategy will overweight assets that rank highly on a certain factor and underweight assets that rank poorly on that factor. The factors explain exactly why the portfolio is positioned the way it is and what the drivers of return are every time.

In embodiments, the quantum computing system 2114 or other systems of the platform 2400 may utilize a value investing approach for picking stocks that appear to be trading for less than their intrinsic or book value. In value investing, equity valuations may be quantified by the ratio of a fundamental anchor-like book value, earnings, or cash flows-over price. In embodiments, the quantum computing system 2114 or other systems of the platform 2400 may be configured to perform a valuation of an asset or a set of assets.

In some embodiments, the quantum computing system 2114 or other systems of the platform 2400 utilize a momentum investing approach for buying assets that have had high returns over the past three to twelve months and selling those that have had poor returns over the same period. In the momentum investing approach, the assets that have recently outperformed will tend to do better than assets that have recently underperformed. In some embodiments, momentum is calculated over the last 12-months price return of an asset.

In embodiments, the quantum computing system 2114 or other systems of the platform 2400 are configured to generate a ranked list of companies. In some embodiments, in the building of trading strategies, the given ranking is based on confidence intervals of the performance of a set of related or comparable assets and/or companies.

In embodiments, the platform 2400 or other systems of the platform 2400 may apply rankings of a series of companies to enable deeper comparative basis than a simple selection of the top or bottom assets. In an example, the platform 2400 may be tasked with investing in ten assets based on the company ranking. Continuing the example, suppose asset X is among these ten assets and is predicted to have a ranking between second and sixth. In embodiments, the quantum computing system 2114 or other systems of the platform 2400 leverage a ranking model to find the optimal ranking. In some embodiments, the ranking model uses the portfolio weights to maximize an objective function, even for the worst realization of the ranking within the uncertainty set.

In embodiments, the quantum computing system 2114 or other systems of the platform 2400 are configured to generate a ranked list of potential transactions. In embodiments, the quantum computing system 2114 or other systems of the platform 2400 apply ranked lists of potential transactions to rebalance a portfolio. The quantum computing system 2114 or other systems of the platform 2400 may be configured to undertake the rebalancing with the goal of minimizing the explicit (e.g., commission) and implicit (e.g., bid/ask spread and impact) costs associated with trading.

In some embodiments, trading costs and constraints may be explicitly considered within portfolio construction. For example, a portfolio optimization that seeks to maximize exposure to some alpha source may incorporate explicit measures of transaction costs or constrain the number of trades that are allowed to occur at any given rebalance.

In some embodiments, the portfolio construction and trade optimization occur in a two-step process. For example, a portfolio optimization may take place that creates the “ideal” portfolio, ignoring consideration of trading constraints and costs. The quantum computing system 2114 or other systems of the platform 2400 may then undertake trade optimization as a second step, seeking to identify the trades that would move the current portfolio “as close as possible” to the target portfolio while minimizing costs or respecting trade constraints.

In embodiments, the quantum computing system 2114 or other systems of the platform 2400 are configured to optimize counterparty matching. In embodiments, the quantum-based matching is based at least in part on complementary trading strategies of the counterparties. In some embodiments, a transaction may include many counterparties. Each marketplace of funds, goods, and services to complete a transaction may be considered as a series of counterparties. For example, if a buyer purchases a retail product online to be shipped to their home, the buyer and retailer are counterparties, as are the buyer and the delivery service. In embodiments, the management of counterparties in complex multi-step processes can be optimized to enable the efficient transfer of funds between parties. In market dealings with a counterparty, there is an innate risk that one of the parties or entities involved will not fulfill their obligations. This is especially true for over-the-counter (OTC) transactions. Examples of OTC transaction risks include, but are not limited to, a vendor not providing a good or service after a payment is processed, that a buyer will not pay an obligation if the goods are provided first, and that one party will back out of the deal before the transaction is executed but after an initial agreement is reached. In embodiments, the quantum computing system 2114 or other systems of the platform 2400 are configured to identify areas of counterparty risk, and these areas of identified risk are then managed as part of the overall quantum market orchestration.

Counterparties on a trade can be classified in several ways and may provide insights into how the market is likely to act based on presence/orders/transactions and other similar-style traders. In embodiments, examples of the counterparties include, but are not limited to, retailers, market makers, liquidity traders, technical traders, momentum traders, and arbitragers.

Retailers may refer to ordinary individual investors or other non-professional traders. They may be trading through an online broker like E-Trade or a voice broker. The quantum computing system 2114 or other systems of the platform 2400 may provide for automated traders who act as counterparties in transactions.

In embodiments, the quantum computing system 2114 or other systems of the platform 2400 provide for automated market makers (AMMs) that are participants to provide liquidity to the market. In embodiments, the AMMs may have substantial market clout and will often be a substantial portion of the visible bids and offers displayed in the order books. Profits may be made by AMMs by providing liquidity and collecting Electronic Communication Network (ECN) rebates, as well as moving the market for capital gains when circumstances dictate a profit may be capturable.

In embodiments, the quantum computing system 2114 or other systems of the platform 2400 include automated liquidity trading modules, which may refer to non-market makers who generally have very low fees and capture daily profits by adding liquidity and capturing the Electronic Communication Network (ECN) credits. As with AMMs, automated liquidity trading modules may also make capital gains by being filled on the bid (offer) and then posting orders on the offer (bid) at the inside price or outside the current market price.

In some implementations, market orchestration system platform 2400 includes quantum-enabled technical trader intelligent agents. In embodiments, the quantum-enabled technical trader intelligent agents are configured to trade based on chart levels, whether from market indicators, support, resistance, trendlines, or chart patterns. Quantum-enabled technical trader intelligent agents may be configured to watch marketplace charts for certain conditions to arise before stepping into a position.

In embodiments, market orchestration system platform 2400 includes quantum-enabled momentum trader intelligent agents. In embodiments, the quantum-enabled momentum trader intelligent agents may be of different types. Some quantum-enabled momentum trader intelligent agents may be configured to stay with a momentum stock for multiple days (even though they only trade it intraday) while others will search for “stocks on the move,” continuously attempting to capture quick sharp movements in stocks during news events, volume, or price spikes. These quantum-enabled momentum trader intelligent agents may be configured to exit when the movement is showing signs of slowing.

In embodiments, the market orchestration system platform 2400 includes quantum-enabled arbitrager intelligent agents. In some embodiments, the quantum-enabled arbitrager intelligent agents are configured to use multiple assets, markets, and statistical tools to exploit inefficiencies in the market or across markets.

In embodiments, the quantum computing system 2114 or other systems of the platform 2400 is configured to optimize order matching. In some embodiments, quantum computing system 2114 includes a quantum order matching system. In embodiments, quantum order matching system is an electronic system that matches buy and sell orders for a marketplace using quantum order matching algorithms. The quantum order matching system executes orders from participants in the marketplace.

In embodiments, orders are entered by traders and executed by a central system that belongs to the marketplace. The quantum order matching algorithm that is used to match orders may vary from system to system and may use rules around best execution. Further, the quantum order matching system and order request system 2160 may be a part of a larger electronic trading system, which may include a settlement system 2141 and a central securities depository that is accessed by electronic trading platforms.

The quantum order matching algorithms may determine the efficiency and the robustness of the quantum order matching system 2131. In embodiments, marketplaces may be configured to support continuous trading where orders are matched immediately and/or auction trading where matching is done at fixed intervals. In some embodiments, the quantum order matching system 2131 functions in an auction state at the market open when a number of orders have built up.

In some implementations, the quantum computing system 2114 or other systems of the market orchestration system platform 2400 are configured to perform opportunity discovery through the process of mining and discovery. Mining and discovery may involve traditional data mining using predictive models and/or text-based data mining modules. In embodiments, traditional data mining using the quantum computing system 2114 or other systems of the market orchestration system platform 2400 is applied to find opportunities for optimization of portfolios through trading activities.

Text mining may refer to the data analysis of natural language works (articles, books, etc.) using text as a form of data. It is often joined with data mining, the numeric analysis of data works (e.g., filings and reports), and referred to as “text and data mining” or, simply, “TDM.”

In some embodiments, TDM may be accomplished by applying quantum computational or Quantum TDM engines (QTDM) 2123 that allow computers to read and digest digital deep insights in the information far more efficiently than a human being. QTDM engines 2123 may be configured to break down digital information into raw data and text, analyze it, and determine new connections. For example, QTDM engines 2123 may determine that subtle shifts in weather patterns relate to a downturn in the price of wheat. In embodiments, the quantum computing system 2114 then applies QTDM engines 2123 to mine news feeds, social media feeds, and/or discussion boards to predict movements of markets for everything from government bonds to commodities.

In embodiments, the quantum computing system 2114 or other systems of the market orchestration system platform 2400 are configured to automatically discover smart contract configuration opportunities. Automated discovery of smart contract configuration opportunities may be based on published APIs to marketplaces and machine learning (e.g., by robotic process automation (RPA) of stakeholder, asset, and transaction types.

In embodiments, the quantum computing system 2114 includes a quantum trading engine 2125. In embodiments, smart contracts are provided by the quantum trading engine 2125 and are executed by a computer network that uses consensus protocols to agree upon the sequence of actions resulting from the smart contract's code. The result is a method by which parties can agree upon terms and trust that they will be executed automatically, with reduced risk of error or manipulation.

In embodiments, quantum-established or other blockchain-based smart contracts applications may include, but are not limited to, validating loan eligibility and executing transfer pricing agreements between subsidiaries. In embodiments, quantum-established or other blockchain-enabled smart contracts enable frequent transactions occurring among a network of parties, and manual or duplicative tasks are performed by counterparties for each transaction. The quantum-established or other blockchain acts as a shared database to provide a secure, single source of truth, and smart contracts automate approvals, calculations, and other transacting activities that are prone to lag and error.

Smart contracts may use software code to automate tasks, and in some embodiments, this software code may include quantum code that enables extremely sophisticated optimized results.

In embodiments, the quantum computing system 2114 or other system of the market orchestration system platform 2400 includes a quantum-enabled or other prospect targeting module that is configured to perform prospect targeting. In embodiments, the prospect targeting module identifies various strategies to find prospects appropriate to the market participant needs. In embodiments, the prospect targeting module participates in online communities, enabling the identification of new prospects through monitoring of sites such as Twitter™, LinkedIn™, Reddit™, and the like.

In some embodiments, the prospect targeting module generates local hashtags and applies these hashtags to find prospects associated with the specific topics of interest.

In embodiments, the prospect targeting module sponsors community events (such as digital events or physical events). In some embodiments, the prospect targeting module identifies specific online advertisements. These specific advertisements may include factors such as geographic specificity, age range, job title, essential keywords, and the nature of social engagement.

In embodiments, the quantum computing system 2114 or other system of the market orchestration system platform 2400 includes a quantum-enabled or other valuation module configured to perform valuation tasks. Valuation may be applied when trying to determine the fair value of an asset or security, which is determined by what a buyer is willing to pay a seller, assuming both parties enter the transaction willingly. When an asset trades in a marketplace, buyers, and sellers determine the market value of the asset. The concept of intrinsic value, however, refers to the perceived value of an asset based on future earnings or some other attribute unrelated to the market price of the asset. In embodiments, the valuation module is used to determine the intrinsic value of an asset. This intrinsic value may be an indicator of the over- or under-valuation of an asset.

In embodiments, the valuation module may leverage absolute valuation models and relative valuation models. In embodiments, the quantum absolute valuation models may attempt to find the intrinsic or “true” value of an investment based only on fundamentals. Fundamentals may refer to dividends, cash flow, growth rates, and the like. Absolute valuation models that may include dividend discount models, discounted cash flow models, residual income models, and asset-based models, and the like. In embodiments, the relative valuation models operate by comparing the asset in question to other similar assets. These methods may involve quantum or other calculations to determine relative performance based on quantitative input data, such as price to earnings ratio and growth numbers to compare the asset to other assets of similar types.

In embodiments, the quantum computing system 2114 or other systems of the market orchestration system platform 2400 may include a quantum-enabled or other risk identification module that is configured to perform risk identification and/or mitigation. The steps that may be taken by the risk identification module may include, but are not limited to, risk identification, impact assessment, and strategies development. In some embodiments, the risk identification module determines a risk type from a set of risk types. In embodiments, risks may include, but are not limited to, preventable, strategic, and external risks. Preventable risks may refer to risks that come from within and that can usually be managed on a rule-based level, such as employing operational procedures monitoring and employee and manager guidance and instruction. Strategy risks may refer to those risks that are taken on voluntarily to achieve greater rewards. External risks may refer to those risks that originate outside and are not in the businesses' control (such as natural disasters). External risks are not preventable or desirable. In embodiments, the risk identification module can determine cost for any category of risk. The risk identification module may perform a calculation of current and potential impact on an overall risk profile.

In embodiments, the step of risk identification module may determine the probability and significance of certain events. Furthermore, the risk identification module may be configured to anticipate events.

In embodiments, the quantum computing system 2114 or other systems of the market orchestration system platform 2400 may be configured for sampling from risk-neutral probability measures for asset pricing. In embodiments, a binomial pricing formula may be interpreted as a discounted expected value. In risk-neutral pricing, the option value at a given node is a discounted expected payoff to the option calculated using risk-neutral probabilities and the discounting is done using the risk-free interest rate. The price of the option may be calculated by working backward from the end of the binomial tree to the front. In embodiments, the derived risk-neutral probabilities are calculated by quantum computing system 2114 or other systems of the market orchestration system platform 2400, providing more precision in the overall asset price calculation.

In embodiments, the quantum computing system 2114 or other systems of the market orchestration system platform 2400 are configured for optimizing asset allocation. The quantum computing system 2114 or other systems of the market orchestration system platform 2400 may be configured to optimize the type and nature of the investment based on the requirements of the investor. For example, an investor requirement may be saving for a new car in the next year. In the present example, the investor might invest her car savings fund in a very conservative mix of cash, certificates of deposit (CDs), and short-term bonds. In a different example, an investor requirement may be placing holdings in much longer-term positions or tax optimized investments if the investor is saving for retirement that may be decades away.

Asset-allocation mutual funds, also known as life-cycle, or target-date funds, may provide investors with portfolio structures that address an investor's age, risk tolerance, and investment objectives with an appropriate apportionment of asset classes, which may be achieved through the application of quantum calculations, by artificial intelligence systems, or by other systems of the market orchestration system platform 2400.

In some embodiments, the quantum computing system 2114 or other systems of the market orchestration system platform 2400 may be configured for hash collision for proof of work in cryptocurrency mining. The value of Bitcoin comes from the difficulty of finding SHA-256 reversals or similar calculations, which gives it “proof of work”. Currently, it is believed that there is no efficient classical algorithm which can invert SHA-256. Hence, the only way is a brute force search, which classically means trying different inputs until a satisfactory solution is found. The quantum computing system 2114 may be configured to solve reversal of SHA-256, thus breaking the “proof of work” requirement on cryptocurrency mining.

In embodiments, the quantum computing system 2114 is configured for quantum-driven Monte Carlo for derivative pricing. The Quantum Monte Carlo (QMC) valuation relies on risk-neutral valuation. In the QMC valuation, the price of the option is its discounted expected value. In embodiments, the QMC valuation technique includes creating a quantum state combining all price paths for the underlying via simulation, resolving the QMC to calculate the optimum associated exercise value/path and discounting the payoffs to today.

In embodiments, the quantum computing system 2114 is configured for quantum-driven Monte Carlo for credit valuation adjustment. Counterparty credit risk (CCR) may refer to the risk that a party to a derivative contract may default before the expiration of the contract and fail to make the required contractual payments. The Quantum Monte Carlo counterparty credit risk (CCR) estimation framework estimators may be developed based on quantum applications of such as quantum implementation of mean square error (MSE) reduction techniques

In embodiments, the quantum computing system 2114 is configured for imaginary-time propagation for multi-asset Black Scholes equation. The Black-Scholes equation may be interpreted from quantum mechanics as the imaginary time Schrödinger equation of a free particle. When deviations of the quantum state of equilibrium are considered, related to market imperfection, such as cost, data challenge, short-term volatility, discontinuities, or serial correlations, the classical non-arbitrage assumption of the Black-Scholes model is violated, implying a non-risk-free portfolio. An arbitrage environment is a necessary condition to embedding the Black-Scholes option pricing model in a more general quantum physics setting.

In some embodiments, the quantum computing system 2114 or other systems of the platform 2400 are configured for accelerated sampling from stochastic processes for risk analysis. In embodiments, quantum-simulated accelerated testing is initialized to hold accelerated life tests with constant-stress loadings, including accelerated degradation tests and time-varying stress loadings. This quantum-accelerated testing results access product reliability and assists with the design of warranty policy.

In embodiments, the quantum computing system 2114 or other systems of the market orchestration system platform 2400 are configured for graph clustering analysis for anomaly and fraud detection. In embodiments, the quantum computing system 2114 or other systems of the market orchestration system platform 2400 are configured for identifying a fraudulent account application. In embodiments, identifying a fraudulent account application may include receiving a new account application comprising a plurality of identity-related fields and linking the identity-related fields associated with the new account application with identity-related fields associated with a plurality of historical account applications. In embodiments, this quantum-enabled fraud detection determines the likelihood that the new account application is fraudulent.

In some embodiments, the quantum computing system 2114 includes a quantum prediction module, which is enabled to accurately predict future market trends. In addition, the quantum prediction module may be configured to generate forecast financial time series, especially for the Foreign Marketplace (FX). Furthermore, the quantum prediction module may construct classical prediction engines to further predict the market trends, reducing the need for ongoing quantum calculation costs, which can be substantial compared to traditional computers.

In embodiments, the quantum principal component analysis (QPCA) algorithm may process input vector data if the covariance matrix of the data is efficiently obtainable as a density matrix, under specific assumptions about the vectors given in the quantum mechanical form. It may be assumed that the user has quantum access to the training vector data in a quantum memory. Further, it may be assumed that each training vector is stored in the quantum memory in terms of its difference from the class means. These QPCA can then be applied to provide for dimension reduction using the calculational benefits of a quantum method.

In embodiments, the quantum computing system 2114 or other systems of the market orchestration system platform 2400 are configured for graph clustering analysis for certified randomness for proof-of-stake blockchains. Quantum cryptographic schemes may make use of quantum mechanics in their designs, which enables such schemes to rely on presumably unbreakable laws of physics for their security. The quantum cryptography schemes may be information-theoretically secure such that their security is not based on any non-fundamental assumptions. In the design of blockchain systems, information-theoretic security is not proven. Rather, classical blockchain technology typically relies on security arguments that make assumptions about the limitations of attackers' resources. In embodiments, blockchain and distributed ledger technologies have applications in market orchestration including cryptocurrencies, insurance, and securities issuance, trading, and selling. Quantum cryptographic schemes may enable nontraditional markets including, but not limited to, the music industry, decentralized IoT, anti-counterfeit solutions, internet applications, and decentralized storage.

In embodiments, the quantum computing system 2114 or other systems of the market orchestration system platform 2400 are configured for detecting adversarial systems, such as adversarial neural networks, including adversarial convolutional neural networks. For example, the quantum computing system 2114 or other systems of the market orchestration system platform 2400 may be configured to detect fake trading patterns.

In embodiments, the market orchestration system platform 2400 is configured to generate “market orchestration digital twins.” The term digital twin may refer to a digital representation of a thing or set of things. A market orchestration digital twin may refer to any digital twin related to a market (including digital twins of marketplaces, assets, workflows, traders, marketplace hosts, brokers, service providers, agents, and the like). Like other systems, services, applications, and components described herein, market orchestration digital twins may be used for a wide range of applications, including participant-facing applications (including various types of users described herein) and applications that are for use by or for a host of a marketplace. These may optionally include research and development applications (including design of new features, components, and applications for the marketplace or its participants, such as those described throughout this disclosure), analytic applications (such as for providing insight relevant to trading activities, marketplace operations, and many other topics), simulations, AI-based monitoring, forecasting/prediction applications, and automation applications (including supervised, semi-supervised and fully autonomous applications, such as involving robotic process automation), among many others. Market orchestration digital twins may include asset digital twins, company digital twins, marketplace digital twins, trader (e.g., buyer and seller) digital twins, marketplace host digital twins, broker digital twins, intelligent agent digital twins, transaction workflow digital twins, marketplace workflow/process digital twins, environment digital twins and/or the like, which are discussed in greater detail throughout the disclosure.

In embodiments, digital twins may be visual digital twins and/or data-based digital twins. A visual digital twin may refer to digital twin that is capable of being depicted in a display such as a traditional 2D display, a 3D display, an augmented reality display, or a virtual-reality display. A data-based digital twin may refer to a data structure that contains a set of parameters that are parametrized to represent a state of the thing or group of things. As used herein, the term “depict” may refer to the visual display of a thing and/or a digital representation of the thing in a data structure (e.g., in a data-based digital twin). In embodiments, visual digital twins may also be data-based digital twins, and vice versa.

In some embodiments, a digital twin may be updated with real-time data, such that the digital twin reflects the state of the thing or set of things in real-time. For example, an asset digital twin of a home listed in a marketplace for real-estate may depict the physical structure of the home (e.g., walls, floors, ceilings, rooms, and the like), as well as objects appearing in the environment (e.g., appliances, fixtures, and the like). Furthermore, depending on the manner in which this digital twin is configured, the digital twin of the home may include things such as piping, electrical wire, foundation, and the like. In some implementations, the digital twin of the home may be updated with data received from sensors and devices (e.g., smart home sensors, other sensors deployed in or around the home, appliances or devices within the home, wearable devices worn by residents of the home, and/or other suitable data sources). In scenarios where the digital twin is of a process or workflow, the digital twin may depict the process or workflow, such as in a graph, flow diagram, Gantt chart, sequence list, or other representation, which may include embodiments involving directed and/or acyclic flows and/or ones including cyclical flows, such as involving loops, such feedback loops, iterative optimization, and many others. For example, in the context of a marketplace workflow, a digital twin of the workflow may depict the status and/or outcomes of different stages in the workflow, the inputs to each stage, the outputs from each stage, the processing operations of each stage, and the like. In some implementations, the market orchestration system platform 2400 may receive data from various sources (e.g., IIoT sensors, video, data from smart home devices, computing devices, or the like) and may update a digital twin involving or related to the process to reflect the received data. For example, the market orchestration system platform 2400 may receive data from sensors deployed in a shipping facility may be used to update the digital twin of a delivery process for an asset purchased from a marketplace to reflect the received data, such as to trigger a transactional term conditioned on whether an item has been shipped.

In embodiments, the digital twin system includes a digital twin data optimization system for enabling data minimization modeling for the purpose of determining minimum threshold data requirements for digital twin modeling. In embodiments, data sources, data types, and the like may be scored and/or ranked by their determined relevance, cost, ease of use, simplicity, and the like for multiple instances and/or types of digital twins. For example, when simulating the orchestration of a new marketplace, the data types thought to be of the highest value, lowest cost, least complex, and most readily obtained may be selected for use. In embodiments, artificial intelligence system of the intelligent services system 2143 may be leveraged for data selection for use in a digital twin. In embodiments, new data types and/or sources may be tested and scored and/or ranked by the digital twin data optimization system.

In embodiments, the market orchestration system platform 2400 may be configured to perform simulations using and/or with respect to one or more digital twins. In embodiments, digital twins may be configured to behave in accordance with a set of constraints, such as laws of nature, laws of physics, mechanical properties, material properties, economic principals, chemical properties, and the like. In this way, the market orchestration system platform 2400 may vary one or more parameters of a digital twin and may execute a simulation within the digital twin that conforms with real-word conditions. In embodiments, the market orchestration system platform 2400 allows users to perform simulations in a marketplace entity (e.g., an asset or a marketplace). For example, a potential buyer considering whether or not to bid on an automobile part listed in a marketplace may subject the digital twin of the automobile part to various simulations prior to making the purchase. Continuing the example, the market orchestration system platform 2400 may vary the conditions (e.g., different temperatures, humidity, motions, forces, and the like) of the environment of the automobile part. In this way, the simulation may be run to help a user decide whether to place a bid. Furthermore, in some embodiments, digital twins may be leveraged to perform simulations to predict future states of the thing or group of things and/or modeling behaviors to extrapolate states of the thing or group of things. For example, the market orchestration system platform 2400 allows users to simulate performance of an asset or a set of assets under different economic conditions by varying the economic conditions (e.g., labor market conditions, economic confidence, and the like). In examples, the market orchestration system platform 2400 may receive sensor readings from temperature sensors, humidity sensors, and fan speed sensors deployed throughout an environment where the environment is listed in a marketplace for physical storage for temperature-sensitive materials. The market orchestration system platform 2400 may apply one or more thermodynamics equations to the received sensor readings and the dimensions of the environment to model the thermodynamic behavior of the environment to determine temperatures in areas that do not have temperature sensors.

Digital twins can be helpful for visualizing the current state of a system, running simulations on those systems, and modeling behaviors, amongst other uses. Depending on the configuration of the digital twin, however, it may not be useful for different users, as the configuration of the digital twin dictates the data that is depicted/visualized by the digital twin. Thus, in some embodiments, the market orchestration system platform 2400 is configured to generate role-based digital twins. Role-based digital twins may refer to digital twins of one or more aspects of a marketplace, where the one or more aspects and/or the granularity of the data represented by the role-based digital twin are tailored to a particular role within the marketplace. In embodiments, the role-based digital twins include trader digital twins, marketplace host digital twins, and broker digital twins.

In some of these embodiments, the market orchestration system platform 2400 generates different types of market orchestration digital twins for users having different roles within the marketplace. In some of these embodiments, the respective configuration of each type of market orchestration digital twin may be predefined with default digital twin data types and default granularities. In some embodiments, a user may define the types of data depicted in the different types of market orchestration digital twins and/or the granularities of the different types of market orchestration digital twins. Granularity may refer to the level of detail at which a particular type of data or types of data is/are represented in a digital twin. For example, a marketplace host digital twin may depict information related to execution quality, percentage of orders price improved, net improvement per order, liquidity multiple, execution speed, effective spread over quoted spread, and the like, but may optionally omit depiction of an asset watch list. In examples, the trader digital twin may depict account balance information, an asset watch list, and performance data for an asset listed in a marketplace. The foregoing examples are not intended to limit the scope of the disclosure. Additional examples and configurations of different market orchestration digital twins are described throughout the disclosure.

In some embodiments, market orchestration digital twins may allow a user (e.g., a trader, a marketplace host, a broker, or the like) to increase the granularity of a particular state depicted in the digital twin (also referred to “drilling down into” a state of the digital twin). For example, a trader digital twin may depict varying granularity snapshots of an asset watch list. Continuing the example, a trader digital twin may depict a stock symbol, market capitalization, and stock price in a marketplace for stocks. In embodiments, a user (e.g., a buyer in a marketplace) may opt to drill down into the asset watch list data via a client application 2212 depicting the trader digital twin. For example, a trader in a marketplace for stocks may select a symbol associated with assets on the asset watch list. In response, the market orchestration system platform 2400 may provide higher resolution watch list data for the particular stocks, such as opening price, high price, low price, volume, P/E/market cap, 52-week high price, 52-week low price, average volume, and the like. In embodiments, market orchestration digital twins may include visual indicators of different states of the marketplace and/or marketplace entities. For example, a red icon may indicate a warning state, a yellow icon may indicate a neutral state, and a green icon may indicate a satisfactory state. As another example, varying colors or other indicators may indicate varying volatility measures for a set of defined time periods, such as hourly, daily, weekly, monthly, quarterly, annually, or the like, including volatility of price, trading volume, trade size, and others. Volatility may or may not be desirable in the context of a user's strategy; for example, day traders may seek high-volatility asset classes, while fundamental investors may be cautious about volatility (such as by using asset allocation across asset classes of varying volatility). Accordingly, indicators for volatility measures (or other measures) may be (optionally automatically) configured based on an identified trading strategy or role of a user, such as by showing more volatile asset classes in green for an interface for a day trader or other volatility-seeking strategy and showing them in yellow for an interface for a volatility-cautious strategy or role. In embodiments, the digital twin may depict strategy-aware indicators (e.g., volatility) as display elements in a digital twin. In embodiments, the digital twin may depict different colored icons to differentiate a condition (e.g., current and/or forecasted condition) of a respective data item. For example, the marketplace host digital twin may depict a red icon with execution speed data to indicate a warning state if execution speeds are slow. This may include execution speed information for the user's trading system, for the marketplace as a whole, or the like. In response, the marketplace host digital twin may depict one or more different data streams relating to the selected data item. In examples, a trader digital twin may depict a green icon with a trending asset. In yet other examples, a trader digital twin may highlight and/or depict green icons with assets recommended for purchase and highlight and/or depict red icons with assets recommended for sale, wherein the recommendations may be generated by machine learning and/or artificial intelligence, such as trained on outcomes and/or by supervised, semi-supervised, or unsupervised learning.

In some embodiments, the market orchestration system platform 2400 supports rolled-up real-time reporting. In some of these embodiments, data from IoT systems, edge and network devices (such as located on or in various premises of business operation or other points of use, located in data centers that support marketplace or other business operations, located in telecommunications networks, and/or located in other locations), wearable devices, enterprise software systems, feeds, event streams, and/or other data sources of the various types described herein or in the documents incorporated herein by reference may undergo one or more data fusion operations (at the platform and/or an edge device), and an AI-based intelligent agent 2134 may report results of analytics performed on the fused data and/or process the fused data types, such as for machine learning, decision support, automation, control operations, or other uses described herein. For instance, a set of sensors deployed on machines or equipment may report characteristics of various components of the machines or equipment. Edge devices may be configured to fuse the sensor data from an environment (e.g., a factory) with other data collected with respect to the environment, whereby the fused data is fed to the digital twin. The market orchestration system platform 2400 may then update the digital twin with the fused data, and an AI system may analyze the digital twin and/or the fused data to identify data items to report.

In embodiments, the market orchestration system platform 2400 is configured to provide a set of marketplace tools that allow for communication/negotiation between users (e.g., buyers, sellers, brokers, and the like). In some embodiments, the marketplace tools allow users to communicate with respect to and/or within one or more market orchestration digital twins. In some embodiments, users can communicate/negotiate while viewing the same digital twin or multiple digital twins. In embodiments, a twin, or an interface thereto, may share underlying data while offering configurations that allow each user to view information relevant to the user's particular role, organization, type, category, or the like. For example, an appraiser may be offered a view representing information relevant to an appraisal of an item of property that is subject to a transaction (such as physical status data, location data and historical price information for comparable assets), while a buyer may be presented with additional information, such as information setting proposed terms and conditions for a transaction (e.g., price, interest rate, timing, escrow requirements, insurance requirements, or the like).

In embodiments, the marketplace tools include a video conferencing service. In some embodiments, the video conferencing service allows users to participate in video conferences within a digital twin. In embodiments, information from video conferences may be used to populate an order request. In embodiments, information from video conferences may be used to populate a smart contract. For example, users may access an environment digital twin via a VR-head set, whereby the participants may view the environment digital twin and see avatars of other participants within the “in-twin” video conference.

In embodiments, marketplace tools include chat and/or instant messaging services. In embodiments, information from chats and/or instant messaging services may be used to populate an order request. In embodiments, information from chats and/or instant messaging services may be used to populate a smart contract request.

In embodiments, users (e.g., a marketplace host) may define the types of market orchestration digital twins that may be generated by the digital twin system 2108. In embodiments, the user may select different types of digital twins that will be supported for the marketplace by the market orchestration system platform 2400 via a GUI presented by the marketplace configuration system 2202. For example, the user may select different types of role-based digital twins from a menu of digital twin types, wherein the different types of role-based digital twins may include asset digital twins, marketplace host digital twins, trader digital twins, company digital twins (e.g., companies associated with assets), agent digital twins, appraiser digital twins, assessor digital twins, advertiser digital twins, and/or broker digital twins. In embodiments, trader digital twins may include buyer and/or seller digital twins. In some embodiments, each type of market orchestration digital twin has a predefined set of states that are depicted in the respective market orchestration digital twin and predefined granularity levels for each state of the set of states. In some embodiments, the set of states that are depicted in the market orchestration digital twin and/or the granularity of each state may be customized (e.g., by the user). In these embodiments, a user may define the different states that are represented in each type of market orchestration digital twin and/or the granularity for each of the states depicted in the digital twin. For example, a trader in a marketplace may wish to have more historical market data depicted in the trader digital twin, such that the historical market data is displayed at a higher granularity. In this example, the trader digital twin may be configured to depict the desired historical market data fields at a granularity level defined by a user (e.g., the historical market data may include historical contract changes data, historical time and sales data, and the like). In examples, a marketplace host may wish to view marketplace performance data at a lower granularity level. In this example, the marketplace host digital twin may be configured to show visual indicators that indicate whether any of the states are at a critical condition, an exceptional condition, or a satisfactory condition. For instance, if execution speed is slow, the marketplace host digital twin may depict that the marketplace performance-state is at a critical level. In this configuration, the marketplace host may select to drill down into the marketplace performance-state, where she may view the execution speed, percentage of orders price improved, net improvement per order, liquidity multiple, and the like.

In embodiments, a user may connect one or more data sources 2124 to the market orchestration system platform 2400. Examples of data sources 2124 that may be connected to the market orchestration system platform 2400 may include, but are not limited to, a sensor system 2174 (e.g., a set of IoT sensors), news sources 2178 (e.g., news websites or CNBC programming), the market data 2180 (e.g., level 1 and level 2 data), the fundamental data 2182 (e.g., asset performance data), reference data 2184 (e.g., marketplace identifiers), historical data 2188 (e.g., historical contract change data), third party data sources 2190, discussion forum data 2135, social network data 2198, regulatory data 2194, and network/edge devices 2192. The data sources 2124 may include additional or alternative data sources without departing from the scope of the disclosure. Once the user has defined the configuration of each respective market orchestration digital twin, where the configuration includes the selected states to be depicted and/or the granularity of each state, the user may then define the data sources 2124 that are fed into the respective market orchestration digital twin. In some embodiments, data from one or more of the data sources may be fused and/or analyzed before being fed into a respective digital twin.

In some embodiments, the user may select other types of market orchestration digital twins that are supported for the marketplace, including asset digital twins, environment digital twins, and/or process digital twins. In some of these embodiments, the user may define the data sources used to generate and/or update these digital twins. In embodiments, the user may define any physical locations to be represented as an environment digital twin. For example, the user may define trading floors, geofences, jurisdictions, manufacturing facilities (e.g., factories), asset locations (e.g., shipping facilities, warehouses, and the like), locations of business operation (e.g., office buildings), locations of consumer use, retail locations, and the like. Each may be given a location identifier and a name or other logical indicator. In embodiments, the marketplace configuration system 2202 may assign an identifier to each item and may associate the location of the item with the identifier. In embodiments, the user may define the types of objects that are included in an environment and/or may be found within the environment. For example, the user may define the types of machines (e.g., factory machines, robots, and the like) that are in the environment, the types of products that are made in, stored in, sold from, and/or received in the environment, the types of sensors/sensor kits that are used to monitor the environment, the types of networking or edge devices that are used in the environment, and the like.

In embodiments, the digital twin system 2108 is configured to generate, update, and serve market orchestration digital twins of a marketplace 2126. In some embodiments, the digital twin system 2108 is configured to generate and serve role-based digital twins on behalf of a marketplace and may serve the role-based digital twins to the marketplace participant user device 2118 (e.g., a mobile device, a tablet, a personal computer, a laptop, or the like). As discussed, during the configuration phase, a user may define the different types of data and the corresponding data sources and data sets that are used to generate and maintain each respective type among the different types of market orchestration digital twins. Initially, the digital twin system 2108 may configure the data structures that support each type of market orchestration digital twin, including any underlying databases or other data sources (e.g., SQL databases, distributed databases, graph databases, relational databases, object databases, blockchain-based databases, and the like) that store data that is ingested by the respective market orchestration digital twins. Once the data structures that support a digital twin are configured, the digital twin system 2108 receives data from one or more data sources 2124. In embodiments, the digital twin system 2108 may structure and/or store the received data in one or more databases. When a specific digital twin is requested (e.g., by a user via a client application 2212 or by a software component of the market orchestration system platform 2400), the digital twin system may determine the views that are represented in the requested digital twin and may generate the requested digital twin based on data from the configured databases and/or real-time data received via an API. The digital twin system 2108 may serve the requested digital twin to the requestor (e.g., the client application 2212 or a backend software component of the market orchestration system platform 2400). After a market orchestration digital twin is served, some market orchestration digital twins may be subsequently updated with real-time data received via the API system 2138.

In embodiments, the digital twin system 2108 may be further configured to perform simulations and modeling with respect to the market orchestration digital twins. In embodiments, the digital twin system 2108 is configured to run data simulations and/or environment simulations using a digital twin. For example, a user may, via a client device, instruct the digital twin system 2108 to perform a simulation with respect to one or more states depicted in a digital twin. The digital twin system 2108 may run the simulation on one or more items represented in the digital twin and may depict the results of the simulation in the digital twin. In this example, the digital twin may need to simulate at least some of the data used to run the simulation of the environment, so that there is reliable data when performing the requested environment simulation. The digital twin system 2108 is discussed in greater detail throughout the disclosure.

In embodiments, the exchange suite 2104 provides a set of various marketplace tools that may be leveraged by various users of a marketplace. The marketplace tools may include “in twin” collaboration tools (e.g., “in twin” video conferencing tools, “in-twin” chat services, and the like), an “in twin” strategies tool, an “in twin” trading practice tool, an “in twin” news tool, an “in twin” screener tool, an “in twin” market monitoring tool, an “in twin” entity profile tool, an “in twin” account management tool, an “in twin” charting tool, an “in twin” order request tool, and an “in twin” smart contract tool. In embodiments, an “in-twin” collaboration tool allows multiple users to view and collaborate within a digital twin. For example, multiple users may be granted access to view an asset digital twin representing a tractor available for lease in a marketplace via the in-twin collaboration tool. Once viewing the tractor digital twin, the users may then change one or more features of the tractor depicted in the tractor digital twin and/or may instruct the digital twin system to perform a simulation. In this example, the results of the simulation may be presented to the users in the digital twin. If the buyer is satisfied with the results of the simulation, he or she may generate a smart contract to lease the tractor via the “in twin” smart contract request tool. The “in twin” smart contract request tool may enable a user (e.g., the buyer) to define tractor leasing terms, which may include lease type (e.g., capital lease or operating lease), lease duration, financial terms, payment due to the lessor, market value of the equipment, tax responsibility, and cancellation provisions. Users may collaborate in additional manners with respect to a digital twin, as will be discussed throughout the disclosure. In some embodiments, the exchange suite 2104 interfaces with third-party applications, whereby data may be imported to and/or from the third-party application. For example, a first user (e.g., the buyer in a marketplace) may request certain information (e.g., additional photos or videos of an asset listed in the marketplace, sensor information (such as from one or more scanning systems), or the like) from a second user (e.g., the seller in the marketplace) via the market orchestration digital twin configured for the first user (e.g., the trader digital twin). In response, the second user may upload/export the requested data to the digital twin system 2108, which may then update the asset information in the trader digital twin configured for the first user. Additional examples and descriptions of the exchange suite 2104 and underlying collaboration tools are discussed throughout the disclosure.

In embodiments, the market orchestration system platform 2400 supports “in-twin” marketplaces. In embodiments, an in-twin marketplace may be accessible via visual market orchestration digital twins (e.g., marketplace digital twins, asset digital twins, trader digital twins, broker digital twins, and company digital twins). In embodiments, an in-twin marketplace may be accessible via visual digital twins of third-party organizations. In these embodiments, the visual digital twins may access the market orchestration system platform 2400 via an API and may allow users that are viewing the respective visual digital twins to participate in one or more marketplace transactions. In embodiments, users may issue a purchase offer for assets and/or services via a third-party digital twin (e.g., request to purchase an asset or service), purchase assets and/or services via the third-party digital twin (e.g., accepting an offer made by another party), view available transactions via the third-party digital twin, negotiate via the third-party digital twin, set proposed terms and conditions for a transaction (optionally including by smart contract configuration) in the digital twin, execute a transaction (such as by executing acceptance of a transaction, including one configured by a smart contract) in the digital twin, search for a transaction offer in the digital twin, place a transaction offer in the digital twin, search for a counterparty in the digital twin, search for an asset, asset type, asset class, or the like in the digital twin, view account information in the digital twin, and/or the like. In embodiments, a user's ability to view specific types of data within a digital twin and/or to engage in transactions on behalf of an organization is governed by the level of clearance of the user. In embodiments, a clearance of a user may include data access rights (e.g., whether the user can view detailed asset data of third-party assets that are involved in a marketplace and granted permissions (e.g., permissions to order items or services)). For example, with respect to a digital twin of a marketplace, an employee/user (e.g., manager) with sufficient clearance may have data access rights to view particular types of data, including the available inventory assets that may be used in transactions (such as or trades or as collateral) and to view the statuses of various assets. In this example, the manager may have permissions to undertake transactions for a defined subset of assets but cannot exceed that subset without authorization of a higher-ranking executive. In examples, with respect to a digital twin of a workflow, an employee/user (e.g., manager) may have access rights to view data obtained from entities involved in the workflow. The foregoing are examples of clearance levels of different types of employees defined with respect to specific types of digital twins. As can be appreciated, different clearance levels may be granted to different users depending on the role of the user, the data types that are available in a particular type of digital twin, and/or the types of marketplaces that are accessible via the digital twin. Furthermore, in some embodiments, some marketplaces are accessible via digital twins that do not require clearances or permissions. In these embodiments, any user can access the same types of data with a particular digital twin and engage in any type of transaction that is supported in the digital twin. For example, in a digital twin of a shopping mall, users (e.g., customers) can examine all the products within the shopping mall and can engage in transactions for those products.

In some embodiments, the market orchestration system platform 2400 includes an SDK where digital twin platforms can enable developers to incorporate specific marketplaces into a respective type of digital twin. In some of these embodiments, a digital twin (vis-à-vis the application presenting the digital twin) may be configured to access one or more features of one or more marketplaces by defining the marketplace(s) (e.g., via a URL or other mechanism) that are accessible from a respective view of the digital twin and defining the one or more features that are available when viewing the respective view the digital twin. In some embodiments, the digital twin may request marketplace data from the market orchestration system platform 2400, whereby the request may include parameters that the market orchestration system platform 2400 uses to identify the most relevant marketplace data, such as a type of data being presented in the digital twin and parameters that provide additional insight on which transactions to serve to the digital twin (e.g., product specifications, marketplace specifications, allowed and/or disallowed transaction partners, certification requirements, and/or the like). In response, the market orchestration system platform 2400 may identify relevant marketplace data (e.g., offers to sell relevant assets or services and/or providers of relevant assets or services that may receive offers to buy their respective assets or services) and may serve the relevant marketplace data to the digital twin. The digital twin may receive the marketplace data and may present the marketplace data in the digital twin (e.g., in proximity to the corresponding portion of the digital twin). The user may then initiate transactions via the marketplace using the marketplace data. For example, the user may initiate a purchase of an asset or service, may provide an offer to purchase an asset or service, may begin negotiations for an asset or service, or the like. Furthermore, as digital twin technology enables the execution of complex simulations, users may run simulations corresponding to real world environments and processes of an organization. In this way, a user may view predicted/simulated future states of the digital twin, which may be used to drive decisions with respect to a transaction. For example, in running simulations of different purchasing strategies, a user may view different simulated outcomes for different purchasing strategies (e.g., simulated outcomes from different combinations and sequences of purchases of tranches of various sizes) associated with an organization's purchasing processes (e.g., multi-market purchasing). In response to each different strategies, the digital twin may obtain and present marketplace data corresponding to each respective strategy, including vendors that provide goods or services that fulfill at least a portion of the strategy and, if available, offers from the vendors to provide goods or services (which may include pricing and additional data, such as timelines, certifications, licenses, and/or the like). In the absence of offers from a service provider, the user may be provided an interface to request a quote or to provide an offer to the service provider for the goods or services (as well as any requirements, such as timelines, certifications, licenses, and/or the like). In this way, the user may view the outcomes of the different strategies and then may initiate transactions to execute a selected strategy from the digital twin of the purchasing process.

In a non-limiting example of an in-twin marketplace, a digital twin of a manufacturing factory (or “factory twin”) may depict, inter alia, the real-time inventory levels of all the parts used to manufacture goods, including raw materials (sheet metal, paints, or the like), single component parts (e.g., screws, springs, belts, chains, tires, or the like), and/or preassembled parts (e.g., engines/electric motors, struts, shocks, axles, infotainment systems, or the like) that are manufactured at different locations and/or purchased from third-parties and shipped to the factory. In this example, the digital twin may be configured to access a marketplace for ordering parts via an API of the market orchestration system platform 2400, where suppliers can offer to sell respective parts and/or receive offers to sell respective parts. In this example, the digital twin may be configured to provide a request to a specified marketplace (e.g., a part-supplies marketplace powered by the market orchestration system platform 2400) that indicates specifications for the parts (e.g., product type, product identifier, product dimensions, material types, required certifications, approved vendors, a number of units needed, and/or other suitable specifications), and the marketplace (e.g., via the market orchestration system platform 2400) may return transaction options for the parts (e.g., parts currently for sale by one or more different suppliers and/or different suppliers that produce the respective parts). In embodiments, a transaction option with respect to a respective supplier may indicate various attributes of the transaction option, such as a description of the parts made by the respective supplier, the amount of available parts from the respective supplier, the estimated shipping time of the parts from the respective supplier, a rating of the supplier, a price (e.g., total price and/or price-per-unit) for the part from the supplier (if an offer to sell), and/or other suitable attributes. In this way, a user with sufficient clearance to view existing inventory of a particular part and to order more inventory can view the existing inventory levels for the particular part and, if the inventory levels are low, may view transaction options for the particular part. The user may then initiate a transaction by selecting one or more of the transaction options. For example, the user may select an offer by a seller to sell a defined number of units at a predefined price or may generate an offer to buy a set number of units at a predefined price. It is noted that the offers to sell or buy may include additional information, such as proposed delivery dates, delivery types, product specifications, indemnifications, warranties, disclaimers, or other suitable information. Continuing this example, the user may leverage the digital twin to perform a simulation of the manufacturing process to determine when certain parts will likely need to be replenished given the factories' throughput, projected sales, predicted downtimes, and the like. In this way, the user can assess different transaction options to find the best available transaction given when a certain shipment of parts needs to be delivered by.

In embodiments, the statuses of individual pieces of equipment or other assets may be determined from sensor data derived from a set of sensors that are part of, affixed to, and/or proximate to the piece of equipment or asset. Furthermore, in some embodiments, the status of the equipment may be derived by running simulations. In embodiments, the status of the equipment may indicate to the viewer/user whether a piece of equipment currently requires service, is likely to require service, or is in working condition. In embodiments, the digital twin may be configured to automatically request transaction options from the market orchestration system platform 2400 in response to a determination that a piece of equipment requires service or may require service. In embodiments, a twin may generate a request that indicates information to obtain a transaction request, such as the location of the equipment or other asset, the type of equipment, the type of issue that needs to be resolved, and the like. In response, the market orchestration system platform 2400 identifies transaction requests that match or best correspond to the information provided in the request. For example, the market orchestration system platform 2400 may return transaction options from services/technicians that specialize in the type of machinery and/or type of issue. In this example, the twin may present the transaction options to the user in relation to the piece of equipment, whereby the user can initiate a transaction from the factory twin.

In embodiments, a marketplace orchestration digital twin may interact with a logistics digital twin. In one example, a logistics twin may present an option to sublease logistics space, such as warehouse space. In this example, the logistics twin may issue a request to the market orchestration system platform 2400 to generate an offer to sublease the warehouse space over a period of time via a specified marketplace. In response, the market orchestration system platform 2400 generates the offer and posts the offer on the specified marketplace. In a similar example, the device manufacturer may have shipped an additional ten containers that were presold prior to shipping. During transit, the purchaser reneges on the deal, thereby requiring temporary storage space. In this example, the marketplace digital twin may, based on information from a logistics twin or other logistics system, provide a warning to the user that an unsold shipment of ten containers is currently in transit to the United States without a storage plan in place. The twin may further request transaction options from the market orchestration system platform 2400, such as for temporary storage space, revision of delivery terms and conditions, modification of insurance, or the like, whereby the request may indicate information relevant to the same. In response, the market orchestration system platform 2400 may identify a set of transaction options for temporary warehouse space near the port of entry and may provide the transaction options to the twin. In response, the twin may present options to the user via the twin, whereby the user may select one or more of the transaction options. In this way, the user may resolve the issue in real-time, such as to ensure that the shipment of devices is stored upon arrival in a cost-effective manner.

In embodiments, the market orchestration system platform 2400 supports in-twin smart contracts. In-twin smart contracts may refer to smart contracts that can be accessed and committed to via a digital twin, that share data structures with a digital twin, that can be parameterized by data of a digital twin system, that can be presented and/or configured within a digital twin, that are integrated with workflows of a digital twin, or the like. In these embodiments, transaction options may be presented to a user via a digital twin, where one or more of the transaction options are associated with a respective smart contract. In these embodiments, the user may commit to a transaction via the digital twin. For example, the user may select a user interface element within the digital twin that commits the user to the transaction. In response to the user selection, the market orchestration system platform 2400 may commit the user to the smart contract. In some embodiments, the market orchestration system platform 2400 may commit the user to a smart contract by parameterizing the smart contract with information obtained from the user. For instance, the market orchestration system platform 2400 may provide an identifier of the party, an amount/type of currency in the transaction, and any other required information (e.g., a location for a delivery or service to be performed, a delivery date/contract expiration date/completion date, a start date, and/or the like).

In embodiments, the market orchestration system platform 2400 trains and deploys intelligent agents on behalf of marketplace users. In embodiments, an intelligent agent is an AI-based software system, such employing robotic process automation, such as in the form of a bot, that performs tasks on behalf of and/or suggests actions to a respective user having a defined marketplace role. In embodiments, the intelligent agent may be trained by the market orchestration system platform 2400 based on interactions of the user with a client application 2212, such as actions taken by a user with respect to a market orchestration digital twin, interactions with sensor data or other data collected by the market orchestration system platform 2400, interactions with one or more software systems that performs or enables a marketplace related task (such as a trading system, an analytic system, a pricing system, a smart contract configuration system, a template-based contracting system, a payments system, an ordering system, an e-commerce system, a cryptocurrency system, a wallet, a register or other point-of-sale system, a fulfillment system, and many others), interactions with hardware or physical systems, and the like. Training may be unsupervised training (such as based on outcome data using a wide variety of feedback metrics, such as outcome data showing profitability of trading activities, purchasing activities, lending activities, selling activities, and many others), supervised training, or semi-supervised training. In embodiments, an intelligent agent may be a trader agent trained for trader roles and workflows, such as identifying favorable trading strategies or trade opportunities (such as arbitrage opportunities), placing bids, accepting bids, configuring and/or negotiating a contract (such as a smart contract), setting trade sizes, and setting orders (including limit orders, call orders, position covering orders, hedge-based orders and many others), including any of the roles and workflows described herein or in the documents incorporated herein by reference. In embodiments, an intelligent agent may be a buyer agent trained for buyer roles and workflows, such as identifying buying opportunities within an asset class, determining a set of orders required to satisfy a strategic rule or criterion (such as an asset allocation criterion), negotiating terms and conditions of a contract (such as a smart contract, such as relating to price, quantity, timing, delivery terms, insurance coverage, warranties, and many others), finding and/or executing undervalued items, bargains, or the like, and many others, including any of the roles and workflows described herein or in the documents incorporated herein by reference. In embodiments, an intelligent agent may be a seller agent trained for seller roles and workflows, such as identifying prospective buyers, configuring contract terms and conditions (such as for smart contracts, such as auction rules, prices, offer size, offer timing, offer volume, promotions, incentives, discounts (e.g., based on volume or timing), delivery terms, fulfillment terms, maintenance and update terms, warranty and liability terms, insurance coverage, and many others), including any of the roles and workflows described herein or in the documents incorporated herein by reference. In embodiments, an intelligent agent may be a broker agent trained for broker roles, such as identifying sellers, identifying buyers, matching buyers to sellers, negotiating commissions and other contractual terms and conditions (such as in smart contracts), identifying service providers, and many others, including any of the broker roles and workflows described herein or in the documents incorporated herein by reference. In embodiments, an intelligent agent may be a marketplace host agent trained for marketplace host roles, such as setting marketplace participation rules, setting rules for configuration of transactions (such as auction rules, bid/ask rules, order types, asset types, and many others), configuring and/or negotiating contracts for marketplace participation (such as smart contracts, such as contracts governing permitted trading activities, permitted participants, and others), setting exchange rates, setting and/or configuring media of exchange (such as fiat or cryptocurrencies, tokens, points, and others), and many others, including any of the host roles and workflows described herein or in the documents incorporated herein by reference. In embodiments, the market orchestration system platform 2400 trains intelligent agents 2134 for other roles within a marketplace, such as a valuation role, an analyst role, a delivery role, an asset inspection role, and the like.

In embodiments, the market orchestration system platform 2400 trains intelligent agents 2134 based on training data that includes actions taken by users and features relating to the circumstances surrounding the action (e.g., the type of action taken, the scenario that prompted the action, and the like). In embodiments, the market orchestration system platform 2400 receives telemetry data from a client application 2212 associated with a particular user and learns the workflows performed by the particular user based on the telemetry data and the surrounding circumstances. For example, the user may be a buyer in a marketplace that is presented an asset digital twin. Among the actions of the buyer may be to run simulations on asset digital twins wherein the asset digital twins represent assets for sale in the marketplace. The states depicted in the asset digital twin may include the condition of the asset digital twin as a result of one or more simulations. In this example, the buyer may buy the asset via the asset digital twin when the asset digital twin is determined to be in a first condition (e.g., a good condition) as a result of one or more simulations and may decline to purchase the asset and search for other assets for sale when the asset digital twin is determined to be in a second condition (e.g., a critical condition) as the result of one or more simulations. The intelligent agent may be trained to identify the buyer's tendencies based on the buyer's previous interaction with the asset digital twin. Once trained, the intelligent agent may automatically buy assets for sale when a particular asset's digital twin is determined to be in the first condition as the result of one or more simulations and may automatically decline to buy the asset and search for other assets if the asset digital twin is in the second condition as the result of one or more simulations. In embodiments, simulations may be based upon and/or incorporate behavioral models that predict behavior of assets (such as physical models that predict physical conditions (such as based on physical, chemical and biological principles), economic models that predict economic behavior (such as models that predict behavior of purchasers, sellers, prices, trading patterns, or the like), human behavioral models (such as psychological models, demographic models, population models, sociological models, game-theoretic models, and many others)), and many others, including any of the models described herein or in the documents incorporated herein by reference and including hybrids and combinations of the foregoing. As one example among many possible models, in a marketplace for wine (or other asset that can improve or deteriorate over time), a simulation may include a physical model that uses sensor data from a storage environment for a unit, a chemical model that predicts the effects of the passage of time under the sensed storage conditions, and an economic model that predicts the value of a unit of a given level of quality based on historical pricing patterns for similar goods. The results may yield an expected value of the asset, as well as a simulation of the price of the asset at different points of time, which an intelligent agent may use as reference information in comparison to a current price and/or a predicted future price, such as to determine automatically (after training upon a set of interactions of users with similar comparisons) whether to hold, buy, or sell. While reference is made to an intelligent agent being trained for a particular user, it is understood that an intelligent agent may be trained using the actions of one or more different users and may be used in connection with users that were not involved in training the intelligent agent. Further discussion of intelligent agents is provided throughout the disclosure.

In embodiments, the intelligent agent system 2110 trains intelligent agents 2134 that perform/recommend actions on behalf of a user. An intelligent agent may be a software module that implements and/or leverages artificial intelligence services to perform/recommend actions on behalf of or in lieu of a user. In embodiments, an intelligent agent may use, link to, integrate with, and/or include one or more machine-learned systems or models (e.g., neural networks, prediction models, classification models, Bayesian models, Gaussian models, decision trees, random forests, and the like, including any described herein or incorporated herein by reference) that perform machine-learning tasks in connection with a defined role. Additionally or alternatively, an intelligent agent may be configured with artificial intelligence rules that determine actions in connection with a defined role. The artificial intelligence rules may be programmed by a user or may be generated by the intelligent agent system 2110. An intelligent agent may be executed at the marketplace participant user device 2118 and/or may be executed by the market orchestration system platform 2400. In the latter embodiments, the intelligent agent may be accessed as a service (e.g., via an API). In embodiments, where an intelligent agent is at least partially executed at a client device, the market orchestration system platform 2400 may train an intelligent agent and may serve the trained intelligent agent to a client application 2212. In embodiments, an intelligent agent may be implemented as a container (e.g., a Docker container) that may execute at the client device 2240 or at the market orchestration system platform 2400. In embodiments, the intelligent agent is further configured to collect and report data to the intelligent agent system 2110, which the intelligent agent system 2110 uses to train/reinforce/reconfigure the intelligent agent. In embodiments, the intelligent agent is integrated into or with a marketplace orchestration digital twin system, such as involving a shared set of data resources, a shared set of computational resources, a shared set of artificial intelligence resources, a shared data schema, a shared user interface, a shared set of workflows, a shared set of applications or services, or the like. In embodiments, integration is within a shared microservices architecture, where intelligent agent services and digital twin services are managed within a common microservices framework.

In some embodiments, the intelligent agent system 2110 (working in connection with the intelligent services system 2143) may train intelligent agents 2134 (e.g., trader agents, buyer agents, seller agents, broker agents, marketplace host agents, regulatory agents, and other intelligent agents) using robotic process automation techniques to perform one or more executive actions on behalf of respective agents. In some of these embodiments, a client application 2212 may execute on the marketplace participant user device 2118 (e.g., a user device, such as a tablet, a VR headset, a mobile device, or a laptop, an embedded device, or the like) associated with a user (e.g., a buyer, a seller, a broker, a role-based expert, a marketplace host, or any other suitable affiliate). In embodiments, the client application 2212 may record the interactions of a user with the client application 2212 and may report the interactions to the intelligent agent system 2110. In these embodiments, the client application 2212 may further record and report features relating to the interaction, such as any stimuli or sets of stimuli that were presented to the user, what the user was viewing at the time of the interaction, the type of interaction, the role of the user, the role of the individual that requested the interaction, and the like. The intelligent agent system 2110 may receive the interaction data and related features and may train an intelligent agent based thereon. In embodiments, the interactions may be interactions by the user with a market orchestration digital twin (e.g., an asset digital twin, a trader digital twin, a broker digital twin, a marketplace digital twin, an environment digital twin, a process digital twin, and the like). In embodiments, the interactions may be interactions by the user with sensor data (e.g., vibration data, temperature data, pressure data, humidity data, radiation data, electromagnetic radiation data, motion data, and/or the like) and/or data streams collected form physical entities (e.g., machinery, a building, a shipping container, or the like). For example, a user may be presented with sensor data from a particular piece of equipment and, in response, may determine that a smart contract request action be taken with respect to the piece of equipment. In this example, the intelligent agent may be trained on the conditions that cause the user to generate a smart contract to sell an asset as well as instances where the user did not generate a contract to sell an asset. In this example, the intelligent agent may learn the circumstances in which a smart contract request action is taken. In embodiments, the intelligent agent system 2110 may train intelligent agents based on user interactions with other marketplace entities (such as network entities and computation entities). For example, the intelligent agent system 2110 may train an intelligent agent to learn the manner by which a trader identifies and engages with a counterparty. In this example, the intelligent agent may be trained to learn the steps undertaken by the trader to identify a counterparty, engage with the counterparty, and any actions undertaken by the trader to pursue a transaction with a counterparty.

In embodiments, an intelligent agent may be implemented as a robot that performs asset inspection actions, asset retrieval actions, payment actions, asset delivery actions, asset servicing actions, asset testing actions, asset valuation actions, asset testing actions, and the like.

In embodiments, the types of actions that an intelligent agent may be trained to perform/recommend include: selection of an asset, pricing of an asset, listing an asset in a marketplace, uploading information related to an asset, identifying counterparties, selecting counterparties, identifying opportunities, selecting opportunities, identifying marketplaces, digitally inspecting an asset, physically inspecting an asset, physically delivering an asset, physically retrieving an asset, configuring a marketplace, configuring a digital twin, placing an order request, generating a smart contract, order matching, selection of a strategy, selection of a task, setting of a parameter, selection of an object, selection of a workflow, triggering of a workflow, ordering of a product, ordering of a process, ordering of a workflow, cessation of a workflow, selection of a data set, selection of a design choice, creation of a set of design choices, identification of a problem, selection of a human resource, providing an instruction to a human resource, amongst other possible types of actions. In embodiments, an intelligent agent may be trained to perform other types of tasks, such as: reporting on an asset, reporting on a counterparty, reporting on a trader, reporting on a status, reporting on an event, reporting on a context, reporting on a condition, reporting on a transaction, determining a model, configuring a model, populating a model, designing a system, engineering a product, maintaining a system, maintaining a device, maintaining a process, maintaining a network, maintaining a computational resource, maintaining equipment, maintaining hardware, repairing a system, repairing a device, repairing a network, repairing a computational resource, repairing equipment, repairing hardware, assembling a system, assembling a device, assembling a process, assembling a network, assembling a computational resource, assembling equipment, assembling hardware, setting a price, physically securing a system, physically securing a device, physically securing a process, physically securing a network, physically securing a computational resource, physically securing equipment, physically securing hardware, cyber-securing a system, cyber-securing a device, cyber-securing a process, cyber-securing a network, cyber-securing a computational resource, cyber-securing equipment, cyber-securing hardware, detecting a threat, detecting a fault, tuning a system, tuning a device, tuning a process, tuning a network, tuning a computational resource, tuning equipment, tuning hardware, optimizing a system, optimizing a device, optimizing a process, optimizing a network, optimizing a computational resource, optimizing equipment, optimizing hardware, monitoring a system, monitoring a device, monitoring a process, monitoring a network, monitoring a computational resource, monitoring equipment, monitoring hardware, configuring a system, configuring a device, configuring a process, configuring a network, configuring a computational resource, configuring equipment, configuring hardware, monitoring technology, replications and partitioning of data, index creation on underlying databases, alteration of runtime parameters, allocation of additional CPU, memory, and disk in virtual environments and physical environments, allocation of additional market orchestration engines, clustering of environments, distribution of environments, coordination of environments between physical locations, monitoring of the dark web, management of regulatory interfaces, management and extension of third party interfaces, geographic setup of local markets, management of remote administration tooling, building of serverless components, alternative front end trading tooling (embedded clients, alternative platforms, SMS trading tools, phone trading tools), and the like.

As discussed, an intelligent agent is configured to determine an action and may output the action to a client application 2212. Examples of an output of an intelligent agent may include a recommendation, a classification, a prediction, a control instruction, an input selection, a protocol selection, a communication, an alert, a target selection for a communication, a data storage selection, a computational selection, a configuration, an event detection, a forecast, and the like. Furthermore, in some embodiments, the intelligent agent system 2110 may train intelligent agents 2134 to provide training and/or guidance rather in addition to or in lieu of outputting an action. In these embodiments, the training and/or guidance may be specific for a particular individual or role or may be used for other individuals.

In embodiments, the intelligent agent system 2110 is configured to provide benefits to experts that participate in the training of intelligent agents 2134. In some embodiments, the benefit is a reward that is provided based on the outcomes stemming from the user of an intelligent agent trained by the expert user. In some embodiments, the benefit is a reward that is provided based on the productivity of the intelligent agent. In some embodiments, the benefit is a reward that is provided based on a measure of expertise of the intelligent agent. In some embodiments, the benefit is a share of the revenue or profit generated by the work produced by the intelligent agent. In some embodiments, the benefit is tracked using a distributed ledger (e.g., a blockchain) that captures information associated with a set of actions and events involving the intelligent agent. In some of these embodiments, a smart contract may govern the administration of the reward to the expert user.

In some embodiments, the intelligent agent system 2110 and/or a client application 2212 can monitor outcomes related to the user's interactions and may reinforce the training of the intelligent agent based on the outcomes. For example, each time the user performs a buying action, the intelligent agent system 2110 may determine the outcome (e.g., whether the outcome is a positive outcome or a negative outcome). The intelligent agent system 2110 may then retrain the intelligent agent based on the outcome. Examples of outcomes may include data relating to at least one of a financial outcome, a profitability outcome, an operational outcome, an order cancellation outcome, a fault outcome, a success outcome, a performance indicator outcome, an output outcome, a consumption outcome, an energy utilization outcome, a resource utilization outcome, a behavioral outcome (such as attention behavior, mobility behavior, purchasing behavior, selling behavior, or others), a cost outcome, a profit outcome, a revenue outcome, a sales outcome, a warranty claim outcome, an insurance claim outcome, a lending outcome (e.g., a default or repayment outcome), a collateralization outcome, and a production outcome. In these embodiments, the intelligent agent system 2110 may monitor data obtained from the various data sources after an action is taken to determine an outcome (e.g., profit increased/decreased and by how much, purchased asset condition, purchased asset performance, whether desired counterparty behavior was induced, and the like). The intelligent agent system 2110 may include the outcome in the training data set associated with the action undertaken by the user that resulted in the outcome.

In some embodiments, the intelligent agent system 2110 receives feedback from users regarding respective intelligent agents 2134. For example, in some embodiments, a client application 2212 that leverages an intelligent agent may provide an interface by which a user can provide feedback regarding an action output by an intelligent agent. In embodiments, the user provides the feedback that identifies and characterizes any errors by the intelligent agent. In some of these embodiments, a report may be generated (e.g., by the client application 2212 or the market orchestration system platform 2400) that indicates the set of errors encountered by the user. The report may be used to reconfigure/retrain the intelligent agent. In embodiments, the reconfiguring/retraining of an intelligent agent may include removing an input that is the source of the error, reconfiguring a set of nodes of the artificial intelligence system, reconfiguring a set of weights of the artificial intelligence system, reconfiguring a set of outputs of the artificial intelligence system, reconfiguring a processing flow within the artificial intelligence system (such as placing gates on a recurrent neural network to render it a gated RNN that balances learning with the need to diminish certain inputs in order to avoid exploding error problems), reengineering the type of the artificial intelligence system (such as by modifying the neural network type among a convolutional neural network, a recurrent neural network, a feed forward neural network, a long-term/short-term memory (LSTM) neural network, a self-organizing neural network, or many other types and combinations), and/or augmenting the set of inputs to the artificial intelligence system.

In embodiments, the intelligent agent may be configured to, at least partially, operate as a double of the user having a role within a marketplace. In these embodiments, the intelligent agent system 2110 trains an intelligent agent based on a training data set that includes a set of interactions by a specific user during the performance of their respective role within the marketplace. For example, the set of interactions that may be used to train the intelligent agent may include interactions of the user with the entities of a marketplace, interactions of the user with other users of the marketplace, interactions of the user with assets listed in the marketplace, interactions of the user with a digital twin, interactions of the user with sensor data obtained from a sensor system, interactions of the user with data streams generated by physical entities, interactions of the user with the computational entities of the marketplace, and the like. In some embodiments, the intelligent agent system 2110 parses the training data set of interactions to identify a chain of reasoning of the user upon a set of interactions. In some of these embodiments, the chain of reasoning may be parsed to identify a type of reasoning of the user, which may be used as a basis for configuring/training the intelligent agent. For example, the chain of reasoning may be a deductive chain of reasoning, an inductive chain of reasoning, a predictive chain of reasoning, a classification chain of reasoning, an iterative chain of reasoning, a trial-and-error chain of reasoning, a Bayesian chain of reasoning, a scientific method chain of reasoning, and the like. In some embodiments, the intelligent agent system 2110 parses the training data set of interactions to identify a type of processing undertaking by the user in analyzing the set of interactions. For example, types of processing may include audio processing in analyzing audible information, tactile or “touch” processing in analyzing physical sensor information, textual information processing in analyzing text, motion processing in analyzing motion information, visual processing in analyzing visual information, spatiotemporal processing in processing spatiotemporal information, mathematical processing in mathematically operating on numerical data, creative processing when deriving alternative options, analytic processing when selecting from a set of options, and the like. In embodiments, identification of a type of reasoning and/or a type of processing may be informed by undertaking brain imaging, such as functional MRI or other magnetic imaging, electroencephalogram (EEG), or other imaging, such as by identifying broad brain activity (e.g., wave bands of activity, such as delta, theta, alpha and gamma waves), by identifying a set of brain regions that are activated and/or inactive during the set interactions of the user that are being used for training of the intelligent agent (such as neocortex regions, such as Fp1 (involved in judgment and decision making), F7 (involved in imagination and mimicry), F3 (involved in analytic deduction), T3 (involved in speech), C3 (involved in storage of facts), T5 (involved in mediation and empathy), P3 (involved in tactical navigation), O1 (involved in visual engineering), Fp2 (involved in process management), F8 (involved in belief systems), F4 (involved in expert classification), T4 (involved in listening and intuition), C4 (involved in artistic creativity), T6 (involved in prediction), P4 (involved in strategic gaming), O2 (involved in abstraction), and/or combinations of the foregoing) or by other neuroscientific, psychological, or similar techniques that provide insight into how humans upon which the intelligent agent is trained are solving particular types of problems that are involved in workflows for which intelligent agents are deployed. In embodiments, an intelligent agent may be configured with a neural network type, or combination of types, that is selected to replicate or simulate a processing activity that is similar to the activity of the brain regions of a human expert that is performing a set of activities for which the intelligent agent is to be trained. As one example among many possible, a trader may be shown to use visual processing region O1 and strategic gaming region P4 of the neocortex when making successful trades, and a neural network may be configured with a convolutional neural network to provide effective replication of visual pattern recognition and a gated recurrent neural network to replicate strategic gaming. In embodiments, a library of neural network resources representing combinations of neural network types that mimic or simulate neocortex activities may be configured to allow selection and implementation of modules that replicate the combinations used by human experts to undertake various activities that are subjects of development of intelligent agents, such as involving robotic process automation. In embodiments, various neural network types from the library may be configured in series and/or in parallel configurations to represent processing flows, which may be arranged to mimic or replicate flows of processing in the brain, such as based on spatiotemporal imaging of the brain when involved in the activity that is the subject of automation. In embodiments, an intelligent software agent for agent development may be trained, such as using any of the training techniques described herein, to select a set of neural network resource types, to arrange the neural network resource types according to a processing flow, to configure input data sources for the set of neural network resources, and/or to automatically deploy the set of neural network types on available computational resources to initiate training of the configured set of neural network resources to perform a desired intelligent agent/automation workflows. In embodiments, the intelligent software agent used for agent development operates on an input data set of spatiotemporal imaging data of a human brain, such as an expert who is performing the workflows, and uses the spatiotemporal imaging data to automatically select and configure the selection and arrangement of the set of neural network types to initiate learning. Thus, a system for developing an intelligent agent may be configured for (optionally automatic) selection of neural network types and/or arrangements based on spatiotemporal neocortical activity patterns of human users involved in workflows for which the agent is trained. Once developed, the resulting intelligent agent/process automation system may be trained as described throughout this disclosure.

In embodiments, a system for developing an intelligent agent 2134 (including the aforementioned agent for development of intelligent agents) may use information from brain imaging of human users to infer (optionally automatically) what data sources should be selected as inputs for an intelligent agent. For example, for processes where neocortex region O1 is highly active (involving visual processing), visual inputs (such as available information from cameras, or visual representations of information like price patterns, among many others) may be selected as favorable data sources. Similarly, for processes involving region C3 (involving storage and retrieval of facts), data sources providing reliable factual information (such as blockchain-based distributed ledgers) may be selected. Thus, a system for developing an intelligent agent may be configured for (optionally automatic) selection of input data types and sources based on spatiotemporal neocortical activity patterns of human users involved in workflows for which the agent is trained.

In embodiments, the intelligent agents 2134 are trained to output actions on behalf of a trader, a buyer, a seller, a broker, a marketplace host and/or an affiliate of a buyer, a seller, a broker, or marketplace host. In these embodiments, an intelligent agent may be trained for marketplace roles, such that a user in a particular marketplace role can train the intelligent agent by performing their respective role. For example, an intelligent agent may be trained for performing actions on behalf of or recommending actions to a user in a particular role within a marketplace. In some of these embodiments, the client application 2212 may provide the functionality of the market orchestration system platform 2400. For example, in some embodiments, users may view market orchestration digital twins and/or may use the exchange suite tools via the client application 2212. During the use of the client application 2212, a buyer may use a screener tool to filter assets by setting criteria via the graphical user interface. Each time the user interacts with the client application 2212, the client application 2212 may monitor the user's actions and may report the actions back to the intelligent agent system 2110. Over time, the intelligent agent system 2110 may learn how the particular user responds to certain situations. For instance, if the user is the seller and each time the price of an asset is within a specific range, the seller places an order request to sell assets, the intelligent agent system 2110 may learn to automatically sell assets when pricing for those assets is within the specific range. Further implementations of the intelligent agent system 2110 are discussed further in the disclosure.

In embodiments, the market orchestration system platform 2400 includes the marketplace databases 2116 that store data on behalf of marketplaces. In embodiments, each marketplace may have an associated data lake that receives data from various data sources 2124, an associated set of blockchains that store transactional data, such as in a set of distributed ledgers, or the like. In some embodiments, the marketplace databases 2116 receive the data via one or more API Systems 2138. For example, in embodiments, the API may be configured to obtain real-time sensor data from one or more sensor systems 2174. The sensor data may be collected in a data lake, a set of blockchains, or the like associated with the marketplace. The digital twin system 2108 and the intelligent services system 2143 may structure the data in the data resources and may populate one or more respective market orchestration digital twins based on the collected data. In some embodiments, the data sources 2124 may include an edge device 2192 that collects sensor data from the sensor system 2174 and/or other suitable IoT devices. In some of these embodiments, the edge devices 2192 may be configured to process sensor data (or other suitable data) collected at a “network edge” of the enterprise. Edge processing of enterprise data may include sensor fusion, data compression, data structuring, and/or the like. In some embodiments, the edge device 2192 may be configured to analyze the collected sensor data and to adjust a sensor data stream based on the contents of the collected sensor data. For example, an edge device 2192 may stream sensor data that is considered anomalous without compression and may compress and stream sensor data that is considered to be within a tolerance range. In this way, the edge device 2192 may provide semi-sentient data streams. In embodiments, the market orchestration system platform 2400 may store the data streams in the data lake and/or may update one or more market orchestration digital twins with some or all of the received data.

In embodiments, the marketplace participant user device 2118 may execute one or more client applications 2212 that interface with the market orchestration system platform 2400. In embodiments, a client application 2212 may request and display one or more market orchestration digital twins. In some of these embodiments, a client application 2212 may depict a market orchestration digital twin corresponding to the role of the user. For example, if the user is a trader, the market orchestration system platform 2400 may provide a trader digital twin to the user. In some of these embodiments, the user data stored at the market orchestration system platform 2400 and/or the client device may indicate the role of the user and/or the types of market orchestration digital twins the user has access to.

In embodiments, the client application 2212 may display the requested market orchestration digital twin and may provide one or more options to perform one or more respective operations corresponding to the market orchestration digital twin and the states depicted therein. In embodiments, the operations may include one or more of “drilling down” into a particular state, exporting a state or set of states into collaborative documents (e.g., into a word processor document, a spreadsheet, a PowerPoint document, an annual report, or the like), performing a simulation, inspecting an asset, or the like. For example, a marketplace host may view a marketplace host digital twin. Amongst the states that may be depicted in the marketplace host digital twin may include notifications of potential issues with marketplace performance. In viewing the marketplace host digital twin, the user may wish to “drill down” into marketplace performance information. In this example, the client application 2212 depicting the marketplace host digital twin may allow the user to view higher granularity marketplace performance information, including execution speed, percentage of orders price improved, net improvement per order, liquidity multiple, and the like.

Referring to FIG. 27, in embodiments, the digital twin system 2108 is executed by a computing system (e.g., one or more servers) that may include a processing system 2702 that includes one or more processors, a storage system 2734 that includes one or more computer-readable mediums, and a network interface 2760 that includes one or more communication units that communicate with a network (e.g., the Internet, a private network, and the like). In embodiments, a processing system 2702 may execute one or more of a digital twin configuration system 2710, digital twin I/O system 2712, a data structuring system 2714, a digital twin generation system 2718, a digital twin perspective builder 2720, a digital twin access controller 2722, a digital twin interaction manager 2724, an environment simulation system 2728, a data simulation system 2730, a digital twin notification system 2732, and a digital twin simulation system 2704. The processing system 2702 may execute additional or alternative components without departing from the scope of the disclosure. In embodiments, the storage system 2734 may store marketplace data, such as a marketplace data lake 2758, a digital twin data store 2738, and/or a behavior datastore 2740. The storage system 2734 may store additional or alternative data stores without departing from the scope of the disclosure. In embodiments, the digital twin system 2108 may interface with the other components of the market orchestration system platform 2400, such as the marketplace configuration system 2202, the exchange suite 2104, the intelligent agent system 2110, and/or the intelligent services system 2143.

In embodiments, the digital twin configuration system 2710 is configured to set up and manage the market orchestration digital twins and associated metadata of market orchestration digital twins and to configure the data structures and data listening threads that power the market orchestration digital twins. In embodiments, the digital twin configuration system 2710 receives the types of digital twins that will be supported for the marketplace, as well as the different states/objects that will be depicted in each type of digital twin. For each type of digital twin, the digital twin configuration system 2710 identifies the types of data that feed or otherwise support each state that is depicted in the respective type of digital twin and may determine any internal or external software requests that are required to support the identified data types. In some embodiments, the digital twin configuration system 2710 determines internal and/or external software requests that support the identified data types by analyzing the relationships between the different types of data that correspond to a particular state/granularity. In embodiments, the digital twin configuration system 2710 determines and manages the data structures needed to support each type of digital twin. For example, for an asset digital twin representing real estate listed in a marketplace, the digital twin configuration system 2710 may instantiate a database (e.g., a graph database that defines the ontology of the property and the objects existing (or potentially existing) within the property and the relationships therebetween), whereby the instantiated database contains and/or references the underlying data that powers the real estate digital twin (e.g., sensor data and analytics, 3D maps, physical asset twins, and the like). In some embodiments, the different types of market orchestration digital twins may be configured in accordance with a set of preference settings and taxonomy settings. In some embodiments, the digital twin configuration system 2710 may utilize pre-defined preferences (e.g., default preference templates for different types of market orchestration digital twins) and taxonomies (e.g., default taxonomies for different types of market orchestration digital twins) and/or receive custom preference settings and taxonomies from a configuring user. Examples of role-specific templates that are used to configure a role-based digital twin may include a trader template, a broker template, and a marketplace host template. Similarly, examples of taxonomies that are used to configure different types of role-based digital twins may include a trader taxonomy, a broker taxonomy, and a marketplace host taxonomy.

In embodiments, the digital twin configuration system 2710 may configure the databases that support each respective market orchestration digital twin (e.g., role-based digital twins, asset digital twins, market orchestration digital twins, and the like), which may be stored on the digital twin data store 2738. In embodiments, for each database configuration, the digital twin configuration system 2710 may identify and connect any external resources needed to collect data for each respective data type. For example, in order to collect data from one or more edge devices 2192, the configuration system 2710 may initiate a process of granting access to the edge devices 2192 to the APIs of the market orchestration system platform 2400.

In embodiments, the digital twin I/O system 2712 is configured to obtain data from a set of data sources. In some embodiments, the digital twin I/O system 2712 (or other suitable components) may provide a graphical user interface that allows a user affiliated with a marketplace to upload various types of data that may be leveraged to generate the market orchestration digital twins. For example, the user may upload 3D scans, images, LIDAR scans, blueprints, 3D floor plans, object types (e.g., products, sensors, machinery, furniture, and the like), object properties (e.g., materials, physical properties, descriptions, price, and the like), output type (e.g., sensor units), and the like. In embodiments, the digital twin I/O system 2712 may subscribe to or otherwise automatically receive data streams (e.g., publicly available data streams, such as RSS feeds, sensor system streams, and the like) on behalf of a marketplace or marketplace entities. Additionally or alternatively, the digital twin I/O system 2712 may periodically query and/or receive data from a connected data source, such as the sensor system 2174 having sensors that sensor data from facilities (e.g., manufacturing facilities, shipping facilities, agricultural facilities, resource extraction facilities, computing facilities, and the like), and/or other physical entities, financial databases, surveys, third-party data sources, and/or third party datastores that store third party data, and edge devices 2192 that report data relating to physical assets (e.g., smart machinery/manufacturing equipment, sensor kits, autonomous vehicles, wearable devices, and the like). In embodiments, the digital twin I/O system 2712 may employ a set of web crawlers to obtain data. In embodiments, the digital twin I/O system 2712 may include listening threads that listen for new data from a respective data source.

In some embodiments, the digital twin I/O system 2712 is configured to serve the obtained data to instances of market orchestration digital twins (which is used to populate digital twins) that are executed by a client device or the market orchestration system platform 2400. In embodiments, the digital twin I/O system 2712 receives data stream feeds and/or collects on behalf in a marketplace and stores at least a portion of the streams into a data lake or other data resource associated with the marketplace.

In embodiments, the data structuring system 2714 builds data into a format and grain that can be consumed by a market orchestration digital twin. In embodiments, the data structuring system 2714 may leverage ETL (extract, transform, load) tools, data streaming, and other data integration tooling to structure the data. In embodiments, the data structuring system 2714 structures the data according to a digital twin data model that may be defined by the digital twin configuration system 2710 and/or a user. A data model may refer to an abstract model that organizes elements of marketplace-related data and standardizes the manner by which those elements relate to one another and to the properties of digital twin entities. For instance, a digital twin data model of a vehicle fleet (e.g., a vehicle fleet listed in a marketplace) may specify that the data element representing a vehicle be composed of a number of other elements which represent sub-elements or attributes of the vehicle (the color of the vehicle, the dimensions of the vehicle, the engine of the vehicle, the engine parts of the vehicle, the owner of the vehicle, and the like). In this example, the digital twin model components may define how the physical attributes are tied to respective physical locations on the vehicle. In embodiments, a digital twin model may define a formalization of the objects and relationships found in a particular application domain. For example, a digital twin model may represent the asset components and how they relate to each other within the various digital twins. Additionally or alternatively, a digital twin data model may define a set of concepts (e.g., entities, attributes, relations, tables, and/or the like) used in defining such formalizations of data or metadata. For example, a “digital twin data model” used in connection with a banking application may be defined using the entity-relationship “data model” and how it is then related to the various market orchestration digital twin views.

In embodiments, the digital twin generation system 2718 serves market orchestration digital twins. In some instances, the digital twin generation system 2718 receives a request for a specific type of digital twin from a client application 2212 being executed by the marketplace participant user device 2118 (e.g., via an API). Additionally or alternatively, the digital twin generation system 2718 receives a request for a specific type of digital twin from a component of the market orchestration system platform 2400 (e.g., the digital twin simulation system 2704). The request may indicate the marketplace, the type of digital twin, and the user (whose access rights may be verified or determined by the digital twin access controller 2722). In some embodiments, the digital twin generation system 2718 may determine and provide the client device 2240 with the data structures, metadata, ontology, and information on hooks to data feeds as well as the digital twin constructs. This information may be used by the client to generate the digital twin in the end user device (e.g., an immersive device, such as AR devices or VR devices, tablet, personal computer, mobile, or the like). In embodiments, the digital twin system 2108 may determine the appropriate perspective for the requested digital twin (e.g., via the perspective builder 2720), any data restrictions that the user may have (e.g., via the digital twin access controller 2722), and in response to the perspective and data restrictions, may generate the requested digital twin. In some embodiments, generating the requested digital twin may include identifying the appropriate data structure given the perspective and obtaining the data that parameterizes the digital twin, as well as any additional metadata that is served with the market orchestration digital twin.

In embodiments, the digital twin generation system 2718 may deliver the market orchestration digital twin to the requesting client application 2212. In embodiments, the digital twin generation system 2718 (or another suitable component) may continue to update a served digital twin with real-time data (or data that is derived from real-time data) as the real-time data is received and potentially analyzed, extrapolated, derived, predicted, and/or simulated by the market orchestration system platform 2400.

In some embodiments, the digital twin generation system 2718 may obtain data streams from various data sources, such as relational databases, object-oriented databases, distributed databases, blockchains, Hadoop file stores, graph databases, and the like that underlie operational and reporting tooling in the environment. In embodiments, the digital twin generation system 2718 may obtain data streams that are associated with the structural aspects of the data, such as the layout and 3D objects within facilities or the hierarchical design of a system of accounts. In embodiments, the data streams may include metadata streams that are associated with the nature of the data and data streams containing primary data (e.g., sensor data, sales data, IoT device data, point-of-sale data, behavioral data, survey data, and many others). For example, the metadata associated with a physical facility may include the types and layers of data that are being managed, while the primary data may include the instances of objects that fall within each layer.

In embodiments, the digital twin perspective builder 2720 leverages metadata, artificial intelligence, and/or other data processing techniques to produce a definition of information required for generation of the digital twin in the digital twin generation system 2718. In some embodiments, different relevant datasets are hooked to a digital twin (e.g., an asset digital twin, a trader digital twin, a marketplace digital twin, a marketplace host digital twin, or the like) at the appropriate level of granularity, thereby allowing for the structural aspects of the data (e.g., system of accounts, pricing data, sensor readings, or the like) to be a part of the data analytics process. One aspect of making a perspective function is that the user can change the structural view or the grain of data while potentially forecasting future events or changes to the structure to guide control. In embodiments, the term “grain of data” may refer to a single line of data. Examples of “grains of data” may include a detailed record of a transaction or a single vibration reading from a vibration sensor. Grain is a characteristic governing to some extent how the data can be combined to form different aggregations. For example, if data is aggregated by whole days, then it is not readily broken down with high accuracy by time of day. Generally, role-based and other market orchestration digital twins benefit from finer levels of data, as the aggregations on such data can be dynamic in nature. It is noted that different types of digital twins, or workflows therein, may involve different “sized” grains of data. For example, the grains of data that feed a marketplace host digital twin may be at a higher granularity level than the grains of data that feed a trader digital twin, or vice versa, depending on the particular workflow involved. In some embodiments, however, a marketplace host may drill down into a state of the marketplace host digital twin and the granularity for the selected state may be increased.

In embodiments, the digital twin perspective builder 2720 adds relevant perspective to the data underlying the digital twin, which is provided to the digital twin generation system 2718. For example, a trader digital twin may link in various other types of fuzzy data with market data and depict the potential impacts of market forces or other forces on a simulated digital twin. These different perspectives generated by the digital twin perspective builder 2720 may combine with the data simulation system 2730 to render relevant simulations of how scenario-based future states might be handled, such as ones involving an asset, an asset class, a workflow, or the like. The digital twin simulation system 2704 provides recommendations related to enhancing the digital twin-represented entity, such as to meet the needs of the anticipated future states.

In embodiments, a digital twin model is based on a combination of data and its relationship to the digital twin environments and/or processes. In embodiments, different digital twins may share the same data and different digital twin perspectives can be the results of a set of metadata built on top of a digital twin data model or data environment. In embodiments, the digital twin data model provides the details of the information to be stored and it is used to build a layered system where the final computer software code is able to represent the information in the lower levels in a form that is appropriate for the digital twin perspective being used.

In embodiments, the digital twin access controller 2722 informs the digital twin generation system 2718 of specific constraints around the roles of users able to view the digital twin as well as providing for dynamically adjustable digital twins that can adapt to, constrain, or release views of the data specific to each user role. For example, sensitive marketplace performance data might be obfuscated from most users when viewing a market orchestration digital twin, but the marketplace host may be granted access to view the marketplace performance information directly. In embodiments, the digital twin access controller 2722 may receive a user identifier and one or more data types. In response, the digital twin access controller 2722 may determine whether the user indicated by the user identifier has access to the one more data types. In some of these embodiments, the user's permissions and restrictions may be indicated in a user database.

In embodiments, the digital twin interaction manager 2724 manages the relationship between the structural view of the data in a market orchestration digital twin (e.g., as depicted/represented by the client application 2212) and the underlying data streams and data sources. In embodiments, this interaction layer makes the digital twin into a window into the underlying data streams through the lens of the structure of the data. In embodiments, the digital twin interaction manager 2724 determines the types of data that are being fed to an instance of a market orchestration digital twin while the instance is being executed by a client application 2212. Put another way, the digital twin interaction manager 2724 determines and serves data for an in-use digital twin. In embodiments, the digital twin interaction manager 2724 feeds raw data received from a data source to the digital twin. For example, vibration sensor readings of a machine listed in a marketplace for machine capacity may be fed directly to the executing digital twin of the machine. In embodiments, the digital twin interaction manager 2724 obtains data and/or instructions that are derived by another component of the market orchestration system platform 2400. For example, the digital twin interaction manager 2724 may obtain analytical data from the intelligent services system 2143 that is derived from incoming financial data, markets data, transaction data, asset performance data, operational data, sensor data, and the like. In this example, the digital twin interaction manager 2724 may then feed the analytical data to a market orchestration digital twin (e.g., trader digital twin), whereby the analytical data may be conveyed to the user. In examples, the digital twin interaction manager 2724 may receive simulated pricing data from the digital twin simulation system 2704 to convey pricing with respect to different assets, whereby the simulated data is derived using historical markets data. In this example, the digital twin interaction manager 2724 may receive requests for different assets from a client device 2240 depicting a market orchestration digital twin and may initiate the simulations for each of the assets. The digital twin interaction manager 2724 may then serve the results of the simulation to the requesting client application 2212.

In embodiments, the digital twin interaction manager 2724 may manage one or more workflows that are performed via a market orchestration digital twin. For example, the market orchestration system platform 2400 may store a set of marketplace workflows, where each marketplace workflow corresponds to a role within a marketplace and includes one or more stages. Workflows may include marketplace design workflows, marketplace set-up workflows, marketplace execution workflows, pricing and/or discounting workflows, trading workflows, currency conversion workflows, payment processing workflows, fulfillment workflows, advertising and promotion workflows, appraisal workflows, governance workflows, transactional workflows (such as smart contract workflows), compliance workflows, policy workflows, authentication workflows, reporting workflows, and many others. In embodiments, the digital twin interaction manager 2724 may receive a request to execute a workflow. The request may indicate the workflow and a user identifier. In response, the digital twin interaction manager 2724 may retrieve the requested workflow and may provide specific instructions and/or data to the client device 2240.

In embodiments, the digital twin simulation system 2704 receives requests to run simulations using one or more digital twins. In embodiments, the request may indicate a set of parameters that are to be varied and/or one or more simulation outcomes to output. In embodiments, the digital twin simulation system 2704 may request one or more digital twins from the digital twin generation system 2718 and may vary a set of different parameters for the simulation. In embodiments, the digital twin simulation system 2704 may construct new digital twins and new data streams within existing digital twins. In embodiments, the digital twin simulation system 2704 may perform environment simulation and/or data simulations. The environment simulation is focused on simulation of the digital twin ontology rather than the underlying data streams. In embodiments, the data simulation system 2730 generates simulated data streams appropriate for respective digital twin environments. This simulation allows for real world simulations of how a digital twin will respond to specific events such as changes in the asset pricing and/or changes in the demand of an asset.

In embodiments, the digital twin simulation system 2704 implements a set of models (e.g., physical mathematical forecasts, logical representations, or process diagrams) that develop the framework where data and the response of the digital twin can be simulated in response to different situational stimuli or sets of stimuli. In embodiments, the digital twin simulation system 2704 may include or leverage a computerized model builder that constructs a predicted future state of either the data and/or the response of the digital twin to the input data. In some embodiments, the computerized model library may be obtained from a behavior datastore 2740 that stores one or more behavior models that defines economic and/or scientific formulas or processes. The computerized digital twin model calculates the results of the model to build an interactive environment where users can watch and manipulate the simulated environment seeing how the entire system responds to specific changes in the environment.

In embodiments, digital twin behavior models may be updated and improved using results of actual experiments and real-world events. The use of such digital twin mathematical models and their simulations avoids actual experimentation, which can be costly and time-consuming. Instead, mathematical knowledge and computational power is used to solve real-world problems cheaply and in a time-efficient manner. As such, the digital twin simulation system 2704 can facilitate understanding of market behavior without actually testing the system in the real world.

In embodiments, simulations may be based upon and/or incorporate behavioral models that predict the behavior of assets and/or other marketplace-related entities (such as physical models that predict physical conditions (such as based on physical, chemical and biological principles)), economic models that predict the economic behavior of assets (such as models that predict the price of assets, the volume of assets traded, transactions involving the assets, or the like) and marketplace-related entities (such as models that predict the behavior of buyers, sellers, traders, companies, government entities, regulatory entities, or the like), human behavioral models that predict the behavior of humans (such as psychological models, physiological models, demographic models, population models, sociological models, game-theoretic models, and many others), and many others, including any of the models described herein or in the documents incorporated herein by reference and including hybrids and combinations of the foregoing.

In some embodiments, behavioral models may be configured to predict the outcome of one or more transactions. In these embodiments, the behavioral models may be configured for select fields (e.g., behavioral models configured for software-as-a-service (SaaS) transactions, behavioral models configured for medical device transactions, behavioral models configured for pharmaceutical transactions, behavioral models for real estate transactions, behavioral models for a vehicle repair service marketplace, and the like).

In embodiments, the simulations may include transaction simulations, buying simulations, selling simulations, trading strategy simulations, supply chain simulations, marketplace configuration simulations, marketing or advertising simulations, Federal Reserve interest rate change simulations, latency simulations, lending simulations, merger simulations, acquisition simulations, regulatory action simulations, workforce-related simulations, government policy and/or spending simulations, asset health simulations, asset performance simulations, off-chain activity simulations, new market entrant simulations, asset aging simulations, recession simulations, inflation simulations, influencer commentary simulations (e.g., commentary from financial news show hosts, chief executive officers, social media accounts or the like), legal outcome simulations (e.g., simulations involving the legal outcome of contract disputes, U.S. Supreme Court decisions, or the like), geopolitical simulations (e.g., war, sanctions, or the like) and many others.

In one non-limiting example, executing simulations of transactions may include varying the number of transactions, the types of transactions, the frequency of transactions, the timing of transactions, the parties involved in the transactions, and the like.

In embodiments, data collected and/or monitored via digital twin simulations may be used to optimize asset allocation, optimize marketing resources, optimize marketplace configuration, and many others. The digital twins and/or the behavioral models may be configured to continuously adapt in real-time as new real-world data is collected.

In embodiments, simulation environments may be constructed using a model capable of predicting future state. These models include deep learning, regression models, quantum prediction engines, and other forms of modeling engines that use historical data to build a future state prediction. In some embodiments, a consideration in making the digital twin models' function is the ability to also show the response of the perspective based digital twin structural elements, (e.g., defining the deformation of the axle of a tractor in response to different size loads). For example, the resultant digital twin representation can then be presented to the user in a virtual reality or augmented reality environment where specific perspectives are shown in their digital twin form.

In embodiments, the digital twin notification system 2732 provides notifications to users via market orchestration digital twins associated with the respective users. In some embodiments, digital twin notifications are an important part of the overall interaction. The digital twin notification system may provide the digital twin notifications within the context of the digital twin setting so that the perspective view of the notification is set up specifically to enable enlightenment of how the notification fits into the general digital twin represented ontology.

In embodiments, executive digital twins may include, but are not limited to, trader digital twins 2742, broker digital twins 2744, marketplace host digital twins 2750, marketplace digital twins 2752, asset digital twins 2754, and the like. The discussion of the different types of digital twins is provided for example and not intended to limit the scope of the invention. It is understood that in some embodiments, users may alter the configuration of the various market orchestration digital twins based on the needs of the marketplace, the reporting structure of the marketplace, and the like.

In embodiments, market orchestration digital twins are generated using various types of data collected from different data sources. As discussed, the data may include the market data 2180, the fundamental data 2182, historical data 2188, reference data 2184, data collected from sensor systems 2174, news sources 2178, third party data sources 2190, edge devices 2192, analytics data 2127, simulation/modeled data 2129, and marketplace databases 2180. In embodiments, the sensor data may be collected from one or more IIOT sensor systems (which may be initially collected by edge devices of the enterprise). In embodiments, historical data 2188 may refer to any data collected by the marketplace and/or on behalf of the marketplace and/or marketplace entities in the past. This may include sensor data collected from sensor systems, account data, transaction data, pricing data, smart contract data, order data, reference data, fundamental data, market data, maintenance data, purchase data, asset data, leasing data, and the like. Analytics data 2127 may refer to data derived by performing one or more analytics processes on data collected by and/or on behalf of the marketplace. Simulation/modeled data 2129 may refer any data derived from simulation and/or behavior modeling processes that are performed with respect to one or more digital twins. The marketplace databases 2116 may be a data lake that includes data collected from any number of sources. In embodiments, the market data 2180 may include data that is collected from disparate data sources concerning or related to marketplaces. The market data 2180 may be collected from many different sources and may be structured or unstructured. In embodiments, the market data 2180 may contain an element of uncertainty that may be depicted in a digital twin that relies on such market data 2180. It is appreciated that the different types of data highlighted above may overlap. For example, historical data 2188 may be obtained from the market data 2180 and/or the marketplace databases 2116 may include analytics data 2127, simulated/modeled data 2129, and/or the market data 2180. Additional or alternative types of data may be used to populate a market orchestration digital twin.

In embodiments, the data structuring system 2714 may structure the various data collected by and/or on behalf of the marketplace and/or marketplace entities. In embodiments, the digital twin generation system 2718 generates the market orchestration digital twins. As discussed, the digital twin generation system 2718 may receive a request for a particular type of digital twin (e.g., a trader digital twin 2742) and may determine the types of data needed to populate the digital twin based on the configuration of the requested type of digital twin. In embodiments, the digital twin generation system 2718 may then generate the requested digital twin based on the various types of data (which may include structured data structured by the data structuring system 2714). In some embodiments, the digital twin generation system 2718 may output the generated digital twin to a client application 2212, which may then display the requested digital twins.

In embodiments, a trader digital twin 2742 is a digital twin configured for a trader e.g., buyer and/or seller) in a marketplace. In embodiments, the trader digital twin 2742 may work in connection with the market orchestration system platform 2400 to provide simulations, predictions, statistical summaries, and decision-support based on analytics, machine learning, and/or other AI and learning-type processing of inputs (e.g., pricing data, counterparty data, asset data, order data, news, discussion boards, and the like). In embodiments, a trader digital twin 2742 may provide functionality including, but not limited to, identifying counterparties, identifying assets, bidding on assets, buying assets, listing assets for sale, removing assets from a listing, selling assets, trading assets, inspecting assets, generating order requests, cancelling order requests, generating smart contracts, strategy generation, risk management, and other trader-related activities.

In embodiments, the types of data that may populate a trader digital twin 2742 may include, but are not limited to: account data, macroeconomic data, microeconomic data, forecast data, demand planning data, analytic results of AI and/or machine learning modeling (e.g., financial forecasting), prediction data, asset data, recommendation data, securities-relevant financial data (e.g., earnings, profitability), industry analyst data (e.g., Gartner quadrant), strategic competitive data (e.g., news and events regarding industry trends and competitors), discussion board data, business performance metrics by business unit that may be relevant to evaluating performance of a company's business units (e.g., P&L, head count, factory health, R&D metrics, marketing metrics, and the like), and the like. In embodiments, the digital twin system 2108 may obtain financial data from, for example, publicly disclosed financial statements, third-party reports, tax filings, public news sources, and the like. In embodiments, the digital twin system 2108 may obtain strategic competitive data from public news sources, from publicly disclosed financial reports, and the like. In embodiments, macroeconomic data may be derived analytically from various financial and operational data collected by the market orchestration system platform 2400. In embodiments, the business performance metrics may be derived analytically, based at least in part on real time operations data, by the intelligent services system 2143 and/or provided from other users and/or their respective trader digital twins.

In embodiments, a trader digital twin 2742 may include high-level views of different states of the marketplace, including account summary information, asset pricing, order activity, real-time representations of assets, historical representations of assets, projected representations of assets (e.g., future states), real-time representations of companies, historical representations of companies, projected representations of companies, news and/or television data, economic sentiment data, asset sentiment data, social media data, discussion board data, charts, countdown to close information, lease terms, smart contract terms, order information, contract terms, and any other mission-critical information. In embodiments, a trader digital twin 2742 may allow a user to access and/or interact with asset digital twins. In embodiments, a trader digital twin 2742 may allow a user to interact with another trader digital twin 2742 and/or a broker digital twin 2744. The trader digital twin 2742 may initially depict the various states at a lower granularity level. In embodiments, a user that is viewing the trader digital twin 2742 may select to drill down into a selected state and view the selected state at a higher level of granularity. For example, the trader digital twin 2742 may initially depict a subset of the various states of a listed asset at a lower granularity level, including a pricing state (e.g., a visual indicator indicating pricing for an asset). In response to a selection, the trader digital twin 2742 may provide data, analytics, summary, and/or reporting including, but not limited to, real-time, historical, aggregated, comparison, and/or forecasted pricing data (e.g., real-time, historical, simulated, and/or forecasted revenues, liabilities, and the like). In this way, the trader digital twin 2742 may initially present the user (e.g., the buyer or seller) with a view of different aspects of the asset (e.g., different indicators to indicate different “health” levels of an asset) but may allow the user to select which aspects require more of her attention. In response to such a selection, the trader digital twin 2742 may request a more granular view of the selected state(s) from the market orchestration system platform 2400, which may return the requested states at the more granular level.

In embodiments, a trader digital twin 2742 may be configured to interface with the exchange suite 2104 to specify and provide a set of marketplace tools that may be leveraged by the trader. The marketplace tools may include an “in-twin” strategies tool, an “in-twin” trading practice tool, an “in-twin” news tool, an “in-twin” screener tool, an “in-twin” market monitoring tool, an “in-twin” entity profile tool, an “in-twin” account management tool, an “in-twin” charting tool, an “in-twin” order request tool, an “in-twin” smart contract system, and “in-twin” collaboration tools. The collaboration tools may include video conferencing tools, “in-twin” collaboration tools, presentation tools, word processing tools, spreadsheet tools, and the like, as described herein. In embodiments, the collaboration tools include various tools that allow communication between marketplace entities. In embodiments, the collaboration tools include digital-twin enabled video conferencing. In these embodiments, the market orchestration system platform 2400 may present participants in the video conference with the requested view of a market orchestration digital twin (e.g., an asset digital twin). For example, during a potential trade, a seller proposing to sell an asset may present the asset digital twin to the potential buyer. In this example, the seller may illustrate the results of simulations performed on the asset.

In embodiments, the trader digital twin 2742 may be configured to simulate one or more aspects of the marketplace. Such simulations may assist the user (e.g., the trader, buyer, and/or seller) in making buying, selling, and/or trading decisions. For example, simulations of a proposed asset purchase may be tested using the modeling, machine learning, and/or AI techniques, as described herein, by simulating economic factors (e.g., interest rates, inflation, unemployment, GDP growth), simulating fundamental factors (earnings, sales, cash flow, book value, enterprise value, dividends), simulating market sentiment, simulating asset physical performance, and/or other suitable marketplace-related parameters. In embodiments, the digital twin simulation system 2704 may receive a request to perform a simulation requested by the trader digital twin 2742, where the request indicates one or more parameters that are to be varied in one or more market orchestration digital twins. In response, the digital twin simulation system 2704 may return the simulation results to the trader digital twin 2742, which in turn outputs the results to the user via the client device display. In this way, the user may be provided with various outcomes corresponding to different parameter configurations. For example, a user may request a set of simulations to be run to test different trading strategies to see how the different strategies affect the overall impact on profits and losses. The digital twin simulation system 2704 may perform the simulations by varying the different trading strategies and may output the financial forecasts for each respective trading strategy. In some embodiments, the user may select a parameter set based on the various outcomes and iterate simulations based at least on the varied prior outcomes. Drawing from the previous example, the user may decide to select the trading strategy that maximizes financial forecasts. In some embodiments, an intelligent agent may be trained to recommend and/or select a parameter set based on the respective outcomes associated with each respective parameter set.

In embodiments, a trader digital twin 2742 may be configured to store, aggregate, merge, analyze, prepare, report, and distribute material relating to pricing, assets, financial reporting, ratings, rankings, financial trend data, income data, or other data related to a marketplace. A trader digital twin 2742 may link to, interact with, and be associated with external data sources, and able to upload, download, aggregate external data sources, including with the market orchestration system platform 20500's internal data, and analyze such data, as described herein. Data analysis, machine learning, AI processing, and other analysis may be coordinated between the trader digital twin 2742 and an analytics team based at least in part on using the intelligent services system 2143. This cooperation and interaction may include assisting with seeding marketplace-related data elements and domains in the digital twin data store 2738 for use in modeling, machine learning, and AI processing to identify an optimal trading strategy or some other marketplace-related metric or aspect, as well as identification of the optimal data measurement parameters on which to base judgment of a trading strategy's success. In embodiments, the digital twin system 2108 abstracts the different views (or states) within the digital twin to the appropriate granularity. For instance, the digital twin system 2108 may have access to all the sensor data collected on behalf of the marketplace as well as access to real-time sensor data streams. In this example, if the sensor readings from a particular physical asset listed in a marketplace (e.g., a piece of manufacturing equipment) are indicative of a potentially critical situation (e.g., failure state, dangerous condition, or the like), then the analytics that indicate the potentially critical situation may become very important to the trader. Thus, the digital twin system 2108, when building the appropriate perspective for the trader, may include a state indicator of the physical asset in the trader digital twin 2742. In this way, the trader can drill down into the state indicator of the physical asset to view the potentially critical situation at a greater granularity (e.g., the machinery and an analysis of the sensor data used to identify the situation).

In embodiments, a trader digital twin 2742 may be configured to report on the performance of assets traded in the marketplace. As described herein, reporting may include financial performance metrics, physical performance metrics, data regarding resource usage, or some other type of reporting data. In embodiments, an intelligent agent trained by the user may be trained to surface the most important reports to the user. For example, if the user (e.g., the trader) consistently views and follows up on P&L but routinely skips over reports relating to economic sentiment, the executive agent may automatically surface reports related to P&L to the user while suppressing economic sentiment data.

In embodiments, a trader digital twin 2742 may be configured to monitor, store, aggregate, merge, analyze, prepare, report, and distribute material relating to marketplace counterparties or named entities of interest. In embodiments, such data may be collected by the market orchestration system platform 2400 via data aggregation, web scraping, or other techniques to search and collect counterparty information from sources including, but not limited to, information on investment and/or acquisitions, press releases, SEC or other financial reports, or some other publicly available data. For example, a user wishing to monitor a certain counterparty may request that the trader digital twin 2742 provide materials relating to the certain counterparty. In response, the market orchestration system platform 2400 may identify a set of data sources that are either publicly available or to which the trader has access (e.g., internal data sources, licensed 3rd party data, or the like).

In embodiments, the client application 2212 that executes the trader digital twin 2742 may be configured with an intelligent agent 2134 that is trained on the trader's actions (which may be indicative of behaviors, and/or preferences). In embodiments, the intelligent agent 2134 may record the features relating to the actions (e.g., the circumstances relating to the user's action) to the intelligent agent system 2110. For example, the intelligent agent 2134 may record each time the user executes a trade (which is the action) as well as the features surrounding the trade (e.g., the type of action, the type of asset, the price of the asset, the counterparty or counterparties, the quantity of assets, market sentiment in relation to the asset, shipping and/or delivery information, and the like). The intelligent agent 2134 may report the actions and features to the intelligent agent system 2110 that may train the intelligent agent 2134 on the manner by which the intelligent agent 2134 can undertake or recommend trading tasks in the future. Once trained, the intelligent agent 2134 may automatically perform actions and/or recommend actions to the user. Furthermore, in embodiments, the intelligent agent 2134 may record outcomes related to the performed/recommended actions, thereby creating a feedback loop with the intelligent agent system 2110.

In embodiments, a trader digital twin 2742 may provide an interface for a trader to perform one or more trader-related workflows. For example, the trader digital twin 2742 may provide an interface for a trader to perform, supervise, or monitor strategy-generating workflows, asset listing workflows, asset inspection workflows, counterparty identification workflows, screening workflows, order workflows, smart contract workflows, shipping and/or delivery workflows, regulatory workflows, and the like.

In some embodiments, an AI-reporting tool may be configured to monitor one or more user-defined marketplace assets and/or marketplace asset properties. Examples of marketplace asset properties may include, but are not limited to, price, opening price, high price, low price, volume, P/E/market cap, 52-week high price, 52-week low price, average volume, and the like.

In embodiments, intelligent agents 2134 are expert agents that are trained to perform tasks on behalf of users (e.g., traders). As discussed, in some embodiments, a client application 2212 may monitor the use of the client application 2212 by a user when using the client application 2212. In these embodiments, the client application 2212 may monitor the states of a market orchestration digital twin that the user drills down into, decisions that are made, and the like. As the user uses the client application 2212, the intelligent agent system 2110 may train one or more machine-learned models on behalf of the particular user, such that the models may be leveraged by an intelligent agent 2134 to perform tasks on behalf of or recommend actions to the user.

In embodiments, the marketplace suite includes a trading practice tool 2133, which may include software tools that may be leveraged to train a user. In embodiments, the trading practice tool 2133 may leverage digital twins to improve training for trading in a marketplace. For example, a trading practice tool 2133 may provide real-world examples that are based on the data collected from the marketplace and may enable a user to train on the real-world examples using virtual pretend money provided by the trading practice tool 2133. The trading practice tool 2133 may present the user with different scenarios via a market orchestration digital twin 2120 and the user may take actions. Based on the actions, the trading practice tool 2133 may request a simulation from the market orchestration system platform 2400, which in turn returns the results to the user. In this way, the user may be trained on scenarios that are based on the actual marketplace of the user.

In embodiments, strategy tools 2140 are software tools that leverage digital twins to assist users to create trading strategies for a marketplace. In embodiments, a strategy tool 2140 may be configured to provide a graphical user interface that allows a trader to create trading strategies. In some embodiments, the strategy tool 2140 may be configured to request a simulation from the market orchestration system platform 2400 given the parameters set in the created strategy. In response, the market orchestration system platform 2400 may return the results of the simulation and the user can determine whether to adjust the strategy. In this way, the user may iteratively refine the strategy to achieve one or more objectives. In embodiments, an intelligent agent 2134 may monitor the track of the actions taken while the strategy is being refined by the user so that the intelligent agent system 2110 may train the intelligent agent 2134 to generate or recommend strategies to the user in the future.

In embodiments, an exchange host digital twin 2748 is a digital twin configured for a marketplace host. In embodiments, the marketplace host digital twin 2750 may work in connection with the market orchestration system platform 2400 to provide simulations, predictions, statistical summaries, decision-support, and configuration and control support based on analytics, machine learning, and/or other AI and learning-type processing of inputs (e.g., operations data, trader data, broker data, asset data, order data, regulatory data, fee data, and the like). In embodiments, a marketplace host digital twin 2750 may provide functionality including, but not limited to, configuring a marketplace/exchange, optimizing a marketplace/exchange, controlling a marketplace/exchange, performing regulatory reporting, risk management, compliance, optimizing profitability, optimizing volume, promotion of the marketplace to traders and other parties, and other marketplace host-related activities.

In embodiments, the types of data that may populate a marketplace host digital twin 2750 may include, but are not limited to: order data, marketplace/exchange performance data (e.g., execution speed, liquidity multiple, percentage of orders price improved, net improvement per order), asset data, demand planning data, trader data, broker data, analytic results of AI and/or machine learning modeling (e.g., marketplace configuration support), prediction data, asset data, recommendation data, securities-relevant financial data (e.g., earnings, profitability), discussion board data, social media data, fee data, regulatory data, and many others.

The marketplace host digital twin 2750 may include high-level views of different states and/or marketplace-related data, including trader data (e.g., number of traders), trader account activity data, transaction data, asset data, regulatory data, fee data, commission data, broker data, execution speed data, execution price data, price improvement data, gross price improvement data, percentage of orders price improved data, net improvement per order data, liquidity data, liquidity multiple data, market share data, latency data, spread data, at or better (AOB) than the National Best Bid or Offer (NBBO) data, effective spread data, effective spread over quoted spread (EFQ) data, savings per order data, order size data, and many other types of data.

The marketplace host digital twin 2750 may initially depict the various states at a lower granularity level. In embodiments, a user that is viewing the marketplace host digital twin 2750 may select a state to drill down into the selected state and view the selected state at a higher level of granularity. For example, the marketplace host digital twin 2750 may initially depict a subset of the various states of marketplace performance at a lower granularity level, including a marketplace performance state (e.g., a visual indicator indicating overall performance for a marketplace). In response to a selection, the marketplace host digital twin 2750 may provide data, analytics, summary, and/or reporting including, but not limited to, real-time, historical, aggregated, comparison, and/or forecasted performance data (e.g., real-time, historical, simulated, and/or forecasted execution speed, liquidity multiples, number of marketplace participants, and the like). In this way, the marketplace host digital twin 2750 may initially present the user (e.g., the marketplace host) with a view of different aspects of the marketplace (e.g., different indicators to indicate different “health” levels of a marketplace) but may allow the user to select which aspects require more of her attention. In response to such a selection, the marketplace host digital twin 2750 may request a more granular view of the selected state(s) from the market orchestration system platform 2400, which may return the requested state(s) at the more granular level.

In embodiments, the marketplace host digital twin 2750 may be configured to simulate one or more aspects of the marketplace. Such simulations may assist the user in making decisions, including, but not limited to, marketplace configuration decisions, fee decisions, and/or operational decisions. For example, simulations of a proposed marketplace configuration may be tested using the modeling, machine learning, and/or AI techniques, as described herein, by simulating marketplace configuration parameters 2206 (e.g., supported asset types, listing requirements, fees, and the like), simulating economic factors, simulating market participation, and/or other suitable marketplace-related parameters. In embodiments, the digital twin simulation system 2704 may receive a request to perform a simulation requested by the marketplace host digital twin 2750, where the request indicates one or more parameters that are to be varied in one or more market orchestration digital twins. In response, the digital twin simulation system 2704 may return the simulation results to the marketplace host digital twin 2750, which in turn outputs the results to the user via the client device display. In this way, the user may be provided with various outcomes corresponding to different marketplace configuration parameters. For example, a user may request a set of simulations to be run to test different fee strategies to see how the different strategies affect the overall impact on profits. The simulation system may perform the simulations by varying the different fee strategies and may output the profit forecasts for each respective fee strategy. In some embodiments, the user may select a parameter set based on the various outcomes and iterate simulations based at least on the varied prior outcomes. Drawing from the previous example, the user may decide to select the fee strategy that maximizes profit forecasts. In some embodiments, an intelligent agent may be trained to recommend and/or select a parameter set based on the respective outcomes associated with each respective parameter set.

In embodiments, a marketplace host digital twin 2750 may be configured to store, aggregate, merge, analyze, prepare, report, and distribute material relating to marketplace performance, marketplace activity, traders, brokers, profits, or other data related to a marketplace.

A marketplace host digital twin 2750 may link to, interact with, and be associated with external data sources, and able to upload, download, aggregate external data sources, including with the MOS's internal data, and analyze such data, as described herein. Data analysis, machine learning, AI processing, and other analysis may be coordinated between the marketplace host digital twin 2750 and an analytics team based at least in part on using the intelligent services system 2143. This cooperation and interaction may include assisting with seeding marketplace-related data elements and domains in the digital twin data store 2738 for use in modeling, machine learning, and AI processing to identify an optimal marketplace configuration or some other marketplace-related metric or aspect, as well as identification of the optimal data measurement parameters on which to base judgment of a trading strategy's success.

In embodiments, a marketplace host digital twin 2750 may be configured to report on the performance of the marketplace. As described herein, reporting may include financial performance metrics, physical performance metrics, data regarding resource usage, or some other type of reporting data. In embodiments, an intelligent agent trained by the user may be trained to surface the most important reports to the user. For example, if the user (e.g., the marketplace host) consistently views and follows up on execution speed but routinely skips over reports relating to liquidity multiple, the executive agent may automatically surface reports related to execution speed to the user while suppressing other data.

In embodiments, the client application 2212 that executes the marketplace host digital twin 2750 may be configured with an intelligent agent 2134 that is trained on the marketplace host's actions (which may be indicative of behaviors and/or preferences). In embodiments, the intelligent agent 2134 may record the features relating to the actions (e.g., the circumstances relating to the user's action) to the intelligent agent system 2110. For example, the intelligent agent 2134 may record each time the user configures a new marketplace (which is the action), as well as the features surrounding the configuration (e.g., the type of assets supported, anonymity rules, listing requirements, fees, supported trading types, shipping and/or delivery rules, and the like). The intelligent agent 2134 may report the actions and features to the intelligent agent system 2110 that may train the intelligent agent 2134 on the manner by which the intelligent agent 2134 can undertake or recommend marketplace configuration tasks in the future. Once trained, the intelligent agent 2134 may automatically perform actions and/or recommend actions to the user. Furthermore, in embodiments, the intelligent agent 2134 may record outcomes related to the performed/recommended actions, thereby creating a feedback loop with the intelligent agent system 2110.

In embodiments, a trader digital twin 2742 may provide an interface for a marketplace host to perform one or more marketplace host-related workflows. For example, the marketplace host digital twin 2750 may provide an interface for a marketplace to perform, supervise, or monitor regulatory workflows, exchange configuration workflows, and the like.

The market orchestration digital twins may be leveraged and/or may interface with other software applications without departing from the scope of the disclosure.

FIGS. 24-26 illustrate embodiments of the market orchestration system platform 2400 including a robotic process automation (RPA) system 2402 configured to automate internal marketplace workflows based on robotic process automation. The RPA system 2402 may develop a programmatic interface to a user interface of an external system 2404 such as devices, programs, networks, databases, and the like. The RPA system 2402 is configured to allow the market orchestration system platform 2400 to interface with an external system 2404 without using an application programming interface (API), or in addition to an API. The RPA system 2402 may develop an action list by watching a user perform a task in a graphical user interface (GUI) and recording the tasks in the action list. The RPA system 2402 may automate a workflow by repeating tasks of the action list in the GUI.

In some embodiments, the RPA system 2402 may include and/or communicate with an RPA AI system 2406 configured to perform robotic process automation processes. The RPA AI system 2406 may employ one or more machine learning techniques to develop one or more machine learned models. The machine learned models may be capable of developing, defining, and/or implementing RPA-based programmatic interfaces to facilitate interfacing of the market orchestration system platform 2400 with one or more external devices.

The RPA system 2402 may be necessary for the market orchestration system platform 2400 to communicate with an external system 2404 that does not have an API or that has an outdated API. For example, the RPA system 2402 may allow the market orchestration system platform 2400 to interface with an older external device that does not include an API or that has an outdated API. The RPA system 2402 may allow the market orchestration system platform 2400 to interface with an external system 2404 similarly to how a user would interface with the external system 2404, such as via a user interface of the external system 2404. In some embodiments, the RPA system 2402 allows the market orchestration system platform 2400 to emulate an action and/or a series of actions performable by a user to interface with an external system 2404. Examples of programmatic interfacing by the RPA system 2402 to interface with an external system 2404 include manipulation of markup language such as HTML, emulating computer mouse movements and/or “clicking on” one or more elements of a user interface, entering information into fillable fields and submitting the information via a client program and/or portal, and transmitting digital signals to an external system 2404 that appear to be from sent from a user device.

In some embodiments, the RPA system 2402 may be configured to facilitate communicating with new and/or updated external systems 2404. When a new external system is developed or an external system is updated, the RPA system 2402 may develop a new and/or updated programmatic interface to facilitate interfacing with the new and/or updated external system by the market orchestration system platform 2400 in a manner that is consistent with interfacing with an outdated external device, i.e., the external device prior to release of the new and/or updated external system. For example, the RPA system 2402 may be configured to provide inputs to the outdated external device, provide inputs to the new and/or updated external device, compare related outputs, and adjust inputs to the new and/or updated external device such that the market orchestration system platform 2400 may interface with the new and/or updated external device in a manner consistent with how the market orchestration system platform 2400 interfaced with the outdated external device.

In some embodiments, the RPA system 2402 may act as an API to outdated and/or external systems 2404. The RPA system 2402 may be configured such that the market orchestration system platform 2400 is externally represented as having an API capable of interfacing with one or more external devices or otherwise being capable of programmatically handling signals transmitted by external devices, wherein the RPA system 2402 has developed a programmatic interface for handling such requests other than an API. For example, an outdated external system may be configured to communicate via a series of signals understood by an outdated API. The RPA system 2402 may configure the market orchestration system platform 2400 to act as if the market orchestration system platform 2400 includes the outdated API.

In some embodiments, the RPA system 2402 may be configured to provide a user interface for use by one or more users of the market orchestration system platform 2400. The RPA AI system 2406 may, by one or more machine learning methods, create a user interface that allows a user to interface with one or more components and/or functions of the market orchestration system platform 2400. The RPA system 2402 may use robotic process automation techniques to operate the user interface created by the RPA AI system 2406. The RPA AI system 2406 may dynamically create and/or adjust the user interface according to variables such as changing market conditions, new and/or modified functions of the market orchestration system platform 2400, new and/or modified conditions of systems external to the market orchestration system platform 2400, and the like. Examples of new and/or modified conditions of systems external to the market orchestration system platform 2400 may include changes to product offerings, changes to product availability, changes to selling and/or buying options, new buying and/or selling parties participating in a marketplace, and the like.

In some embodiments, the RPA system 2402 may be configured to perform robotic process automation for multiple market systems in parallel. For example, the market orchestration system platform 2400 may be configured to manage a plurality of marketplaces, each of which require interfacing with users. The RPA system 2402 may manage the plurality of marketplaces substantially simultaneously and may compare input commands and related outputs from each market of the plurality of markets by a plurality of users in parallel. Management may, in one non-limiting example, include setting exchange rates, such as for trading between native currencies of each marketplace, such as among fiat currencies, cryptocurrencies, tokens, in-kind asset exchanges, and other mechanisms of exchange of value. Management may, in another non-limiting example, include identification of discrepancies in value, such as ones that create large arbitrage opportunities across marketplaces, and configuring marketplace rules, execution or the like to harmonize the marketplaces or otherwise mitigate adverse effects.

In some embodiments, the RPA system 2402 may be configured to avoid detection of robotic process automation by systems external to the market orchestration system platform 2400. Some of the external systems 2404 may be designed to attempt to detect when the external system is communicating with a system using robotic process automation, such as the market orchestration system platform 2400. Upon detecting that the market orchestration system platform 2400 is using robotic process automation, the external system may restrict, eliminate, or modify communication capabilities of the market orchestration system platform 2400 with the external system. The RPA system 2402 may emulate human interfacing with the external system to “trick” the external system into believing that the RPA system 2402 is a human user to avoid detection of the robotic process automation and avoid restriction or elimination of communication by the external system. The RPA system 2402 may avoid detection by, for example, dynamically changing paths of interaction with the external system, interacting with user interface elements with inconsistent timing, making human-like errors such as “mis clicks” or “typos,” and the like.

In some embodiments, the RPA AI system 2406 may be configured to create a machine learned model for avoiding detection of robotic process automation. The machine learned model may be created by using data from interaction with one or more graphical interfaces by real human beings and developing robotic process automation techniques that emulate ways in which real humans' interface with the one or more graphical user interfaces. For example, training data may include mouse and/or touch timings and accuracy, typing speed and accuracy, elements of the graphical user interface used, and the like.

In some embodiments, the RPA system 2402 may be configured to validate data transmitted to and/or received from external systems 2404. The RPA system 2402 may validate one or more of data transmitted to the market orchestration system platform 2400 by users of the external system, data transmitted to the market orchestration system platform 2400 by users of the market orchestration system platform 2400, and/or data transmitted to the external system by users of the market orchestration system platform 2400. The RPA system 2402 may validate data by one or more of performing optical character recognition, performing image recognition and/or processing, identifying data stored on webpages, receiving data from a backend database of the external system, receiving data from a backend database of the market orchestration system platform 2400, and the like.

In some embodiments, the RPA AI system 2406 may be configured to develop one or more machine learned models for data validation. For example, the RPA AI system 2406 may use data transmitted by users and/or data received from one or more databases and/or sources external to the market orchestration system platform 2400 as training data to “learn” to identify valid data. The RPA AI system 2406 may transmit the one or more machine learned models for data validation to the robotic process automation system 2402. The robotic process automation system 2402 may implement the one or more machine learned models for data validation.

In some embodiments, the RPA system 2402 may be configured to facilitate validation of processes performed by the RPA system 2402. The RPA system 2402 may create a plurality of process validation logs as the RPA system 2402 performs one or more processes related to the market orchestration system platform 2400 and/or external systems 2404 on behalf of one or more users. The process validation logs may include one or more of timestamps, transaction receipts, user interface screenshots, or any other suitable data entry, file, and the like for providing validation of processes performed by the RPA system 2402. The RPA system 2402 may store the process validation logs in one or more databases and may transmit the process validation logs to the market orchestration system platform 2400 and/or users of the market orchestration system platform 2400. The RPA system 2402 may transmit the process validation logs automatically according to a schedule, upon demand by a user of the market orchestration system platform 2400, upon one or more conditions being true, and the like.

In some embodiments, the RPA system 2402 may be configured to adjust behavior of the robotic process automation in response to feedback acquired via one or both of data validation and process validation. A user of the market orchestration system platform 2400 may view validations of data provided by the RPA system 2402 and, in response to the validations of data, instruct the RPA system 2402 to adjust behavior of the robotic process automation system 2402. A user of the market orchestration system platform 2400 may view one or more of the process validation logs and, in response to the one or more process validation logs, instruct the RPA system 2402 to adjust behavior of the robotic process automation system 2402. Adjustment of behavior of the RPA system 2402 may include using different robotic process automation techniques to perform features of the RPA system 2402, such as, for example, changing RPA-based user interface elements presented to users of the market orchestration system platform 2400, adjusting how the RPA system 2402 interfaces with one or more external systems 2404, and any other suitable adjustment by the RPA system 2402.

In some embodiments, the RPA AI system 2406 may use data validation information and/or feedback, process validation logs, or a combination thereof as training data. The RPA AI system 2406 may train one or more machine learned models to influence, adjust, and/or otherwise control behavior of the RPA system 2402 based upon the data validation information and/or feedback, process validation logs, or a combination thereof.

In some embodiments, the RPA system 2402 may be configured to perform image processing to recognize images in graphical user interfaces with which the RPA system 2402 interfaces. Graphical user interfaces of external systems 2404 with which the RPA system 2402 interfaces may be changed and/or updated, thereby potentially disrupting robotic process automation-based interfacing with the GUI. The RPA system 2402 may automatically detect changes to the GUI via image recognition and/or image processing. The RPA system 2402 may automatically update robotic process automation-based interfacing with the updated GUI to facilitate continued interfacing with the updated GUI and avoid errors or interruptions in communication with the external system.

In some embodiments, the RPA AI system 2406 may use image process optimization to use one or more machine learned models to automatically correct robotic process automation-based interfacing with the external system of the RPA system 2402. For example, the RPA AI system 2406 may use a plurality of GUIs having images as training data to create a machine learned model capable of automatically detecting changes in GUIs of external systems 2404 and determining how to adjust robotic process automation of the RPA system 2402 such that the RPA system 2402 may automatically continue interfacing with the GUI in light of a change to the GUI.

In some embodiments, the RPA system 2402 may be configured to develop a human training system for instructing humans to interface with one or more user interfaces of the market orchestration system platform 2400 and/or one or more external systems 2404. The human training system may teach one or more human users a plurality of actions and/or techniques employed by the RPA system 2402 to interface with the one or more user interfaces such that the human users may perform tasks similarly to the RPA system 2402. The human training system may include one or more documents, videos, tutorials, and the like for facilitating human learning of actions and/or techniques for interfacing with the user interfaces.

In some embodiments, the RPA system 2402 may be configured to process and document success criteria of robotic process automation implemented by the RPA system 2402. The processed and documented success criteria is descriptive such that a human user of the market orchestration system platform 2400 and/or the RPA system 2402 may use the processed and documented success criteria to understand one or more process steps and/or algorithms used by the RPA system 2402 to facilitate interfacing with external systems 2404 and/or to automate internal marketplace workflows of the market orchestration system platform 2400.

In some embodiments, the RPA system 2402 may implement gamification of robotic process automation capabilities of the market orchestration system platform 2400. The gamification of robotic process automation capabilities may include awarding points to users for performing tasks desirable to operation of the market orchestration system platform 2400 and/or desirable for improvement of robotic process automation operations of the market orchestration system platform 2400. For example, points may be awarded for augmentation of a robotic process automation algorithm. Users who have been awarded points may compete with one another, and digital and/or physical prizes may be awarded to users who have achieved one or more point thresholds and/or have ranked above one or more other users on a points leaderboard.

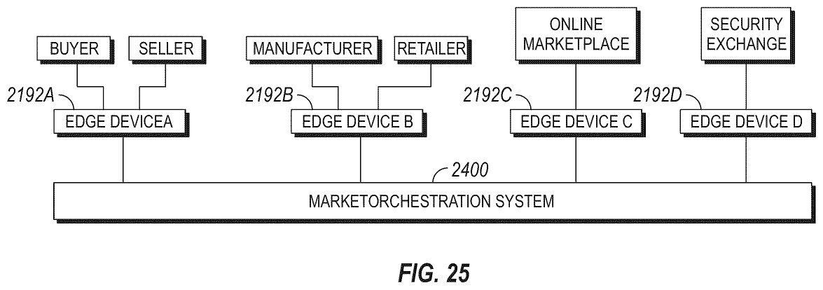

FIG. 25 illustrates embodiments of the market orchestration system platform 2400 including an edge device 2192 configured to perform edge computation and intelligence. In some embodiments, edge computation and intelligence may include performing one or both of data processing and data storage in an area that is physically close to where the processed and/or stored data is needed. In some embodiments, the market orchestration system platform 2400 may include a plurality of edge devices 2192. By way of example, the edge device 2192 may be a router, a routing switch, an integrated access device, a multiplexer, a local area network (LAN) and/or wide area network (WAN) access device, an Internet of Things device, and/or any other suitable device. In some embodiments, edge computation and intelligence may include performing data processing and/or data filtering. The processed and/or filtered data may be transmitted directly to devices that will use the processed and/or filtered data. The processed and/or filtered data may be transmitted along transmission paths with less congestion than general-purpose or high-traffic data transmission paths. Transmission of the processed and/or filtered data may use lower bandwidth than would transmission of unprocessed and/or unfiltered data.

In some embodiments, the edge device 2192 may implement local edge intelligence to anticipate market-driving factors using data received by and/or stored by the edge device 2192. The edge device 2192 may be directed to collecting and processing data related to one or more of a particular buyer and/or seller, product, class of products, class of buyers and/or sellers, market, class of markets, and the like. In some embodiments, the edge device 2192 may be situated physically near to a remote market and/or trading area. For example, the edge device 2192 may be positioned and configured to collect data regarding transactions related to a particular type of product in a geographical region. The edge device may perform data processing, analytics, filtering, trend finding, prediction making, etc. related to the data and may send processing results, analytics, filtered data, trends, predictions, etc. or portions thereof to a more centralized server, processor and/or data center within the market orchestration system platform 2400.

In some embodiments, the edge device 2192 may be configured to perform decision making while being physically and/or electronically isolated from some or all other components of the market orchestration system platform 2400. Herein, electronic isolation may mean or include being temporarily unable to communicate with one or more other systems, devices, components, etc. The edge device 2192 may make decisions based upon outputs and/or conclusions drawn from the data processing, analytics, filtering, trend finding, prediction making, etc. related to data received by the edge device 2192. Examples of decisions made by the edge device 2192 include whether to validate one or more pieces of data, whether to validate a user of the market orchestration system platform 2400 or a portion thereof, whether a transaction has been performed, whether to perform a transaction, and the like. The edge device 2192 may transmit data related to decisions made by the edge device 2192 to other components of the market orchestration system platform 2400.

In some embodiments, in cases where the edge device 2192 is temporarily electronically isolated from other components of the market orchestration system platform 2400, the edge device 2192 may make decisions on behalf of other components of the market orchestration system platform 2400, and may have the decisions audited, evaluated, and/or recorded by other components of the market orchestration system platform 2400 upon being reconnected with the other components of the market orchestration system platform 2400. The edge device 2192 may be restricted from making some decisions in absence of connection to and/or oversight by other components of the market orchestration system platform 2400. Examples of restricted decisions may include decisions related to transactions where confidentiality and/or security are of concern, where intellectual property, trade secrets, and/or proprietary information are to be transmitted, and the like.

In some embodiments, the edge device 2192 may store a copy of a distributed ledger, the distributed ledger containing information related to one or more marketplaces and/or transactions managed by the market orchestration system platform 2400. The distributed ledger may be a cryptographic ledger, such as a blockchain. The edge device 2192 may write blocks to the distributed ledger containing market orchestration information and may have the blocks verified by comparison with copies of the distributed ledger stored on other components of the market orchestration system platform 2400.

In some embodiments, the distributed ledger may be configured to manage ownership of property such as physical goods, digital goods, intellectual property, and the like. An initial owner of property, such as a seller, may be recorded in a block of the distributed ledger. The distributed ledger may record changes in ownership as ownership of the property changes, such as from a seller to a buyer, from a manufacturer to a retailer to a buyer, etc.

In some embodiments, the market orchestration system platform 2400 may include a ledger management system configured to manage a network of devices, such as edge devices, that store copies of the distributed ledger. The devices that store copies of the distributed ledger may be configured to transmit copies stored thereon to the ledger management system for aggregation, comparison, and/or validation. The ledger management system may establish a whitelist of trusted parties and/or devices, a blacklist of untrusted parties and/or devices, or a combination thereof. The ledger management system may assign permissions to particular users, devices, and the like. Versions of the distributed ledger may be compared to prevent duplicate transactions such as the sale of multiple copies of a unique good. In embodiments, where the market orchestration system platform 2400 includes a plurality of edge devices 2192, edge devices 2192 of the plurality of edge devices 2192 may each store a copy of the distributed ledger and may compare copies against one another with respect to validation of blocks and addition of new blocks by some and/or all of the edge devices 2192.

In some embodiments, the market orchestration system platform 2400 may implement one or more distributed update management algorithms for updating distributed devices such as the edge device 2192. The distributed update management algorithm may include one or more procedures for how and when to roll out updates to the distributed devices. The market orchestration system platform 2400 may manage versions of market orchestration and/or edge computation software via the distributed update management algorithms. The distributed devices may receive updates directly from the market orchestration system platform 2400, may transmit updates to one another, or a combination thereof.

In some embodiments, wherein the market orchestration system platform 2400 includes a plurality of edge devices 2192, the edge devices 2192 may communicate with one another to record and/or validate transactions. The edge devices 2192 may also communicate data with one another related to one or more markets, products, regions, users, traders, buyers, sellers, third parties, and the like. An edge device 2192 of the plurality of edge devices 2192 may communicate such information when able in cases where an edge device 2192 is electronically isolated from other edge devices 2192 and/or other components of the market orchestration system platform 2400.

In some embodiments, a first edge device 2192A that is electrically isolated and is assigned to orchestrate a particular trade and/or market may be supported by a second edge device 2192B. The second edge device 2192B may be assigned to orchestrate the same particular trade and/or market in case the first edge device 2192A fails to orchestrate the trade and/or market and/or is out of communication with other components of the market orchestration system platform 2400 for an extended period of time such that orchestration of the trade and/or market by the first edge device 2192A is unverifiable. Upon reentering communication range, the first edge device 2192A may update the second edge device 2192B and/or other components of the market orchestration system platform 2400 with transactions and/or other orchestration operations that took place while the first edge device 2192A was electronically isolated. Similarly, edge devices 2192C, 2192D may act as supports for other edge devices.

In some embodiments, the market orchestration system platform 2400 may implement a hardware failure algorithm configured to make decisions when one or more components of the market orchestration system platform 2400, such as the edge device 2192, ceases operation and/or is otherwise unable to completely operate properly. The hardware failure algorithm may include, for example, assigning an edge device 2192 to overtake operations that had been previously assigned to a now malfunctioning or nonfunctioning edge device 2192.

In some embodiments, the market orchestration system platform 2400 may implement a data routing algorithm configured to optimize flow of data transmitted to and/or from the edge device 2192, other components of the market orchestration system, external systems 2404, or a combination thereof. The edge device 2192 may include one or more signal amplifiers, signal repeaters, digital filters, analog filters, digital-to-analog converters, analog-to-digital converter, and/or antennae configured to optimize the flow of data. In some embodiments, the network enhancement system may include a wireless repeater system such as is disclosed by U.S. Pat. No. 7,623,826 to Pergal, the entirety of which is hereby incorporated by reference. The edge device 2192 may optimize the flow of data by, for example, filtering data, repeating data transmission, amplifying data transmission, adjusting one or more sampling rates and/or transmission rates, and implementing one or more data communication protocols. In embodiments, the edge device 2192 may transmit a first portion of data over a first path of the plurality of data paths and a second portion of data over a second path of the plurality of data paths. The edge device 2192 may determine that one or more data paths, such as the first data path, the second data path, and/or other data paths, are advantageous for transmission of one or more portions of data. The edge device 2192 may make determinations of advantageous data paths based upon one or more networking variables, such as one or more types of data being transmitted, one or more protocols being suitable for transmission, present and/or anticipated network congestion, timing of data transmission, present and/or anticipated volumes of data being or to be transmitted, and the like. Protocols suitable for transmission may include transmission control protocol (TCP), user datagram protocol (UDP), and the like. In some embodiments, the edge device 2192 may be configured to implement a method for data communication such as is disclosed by U.S. Pat. No. 9,979,664 to Ho et al., the entirety of which is hereby incorporated by reference.

In some embodiments, the edge device 2192 may implement a hostile trading detection algorithm configured to detect and protect the market orchestration system platform 2400 against external systems 2404 attempting to fraudulently interact with the market orchestration system platform 2400. Examples of attempting to fraudulently interact with the market orchestration system platform 2400 include submitting false transaction information, false product information, false user and/or party information, attempting to make the market orchestration system platform 2400 perform and/or orchestrate a fraudulent transaction, and the like. The hostile trading detection algorithm may be implemented via a machine learning model trained to detect and/or protect against fraudulent interaction.

In some embodiments, the edge device 2192 may implement gamification of distributed computing capabilities of the market orchestration system platform 2400. The gamification of distributed computing capabilities may include awarding points to users for performing tasks desirable to operation of the market orchestration system platform 2400 and/or desirable for improvement of robotic process automation operations of the market orchestration system platform 2400. For example, points may be awarded for trading goods of a particular type and/or within a particular region. Users who have been awarded points may compete with one another, and digital and/or physical prizes may be awarded to users who have achieved one or more point thresholds and/or have ranked above one or more other users on a points leaderboard.

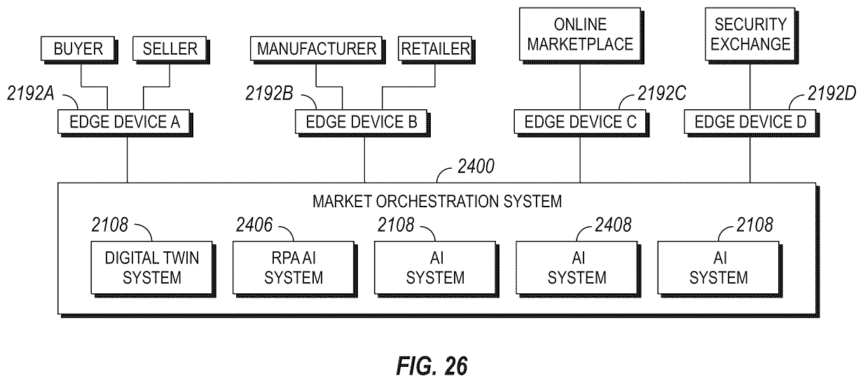

FIG. 26 illustrates embodiments of the market orchestration system platform 2400 including a digital twin system 2108 configured to receive data from the edge device 2192 and create a digital replica, i.e., a digital twin, from the received data. The digital replica created by the digital twin system 2108 may be a digital replica of one or more of a market, a product, a seller, a buyer, a transaction, and the like and may be created using any or all of the data received from the edge device 2192. The edge device 2192 may transmit market orchestration-related data, such as data related to a market, a product, a seller, a buyer, a transaction, and the like, or a combination thereof. In embodiments, where the market orchestration system platform 2400 includes a plurality of edge devices 2192, the digital twin system 2108 may create the digital replica based on data received from multiple of the plurality of edge devices 2192.

In some embodiments, the digital twin system 2108 may be configured to present a simulation of a market, a product, a seller, a buyer, a transaction, or a combination thereof via the digital replica. The digital replica may be a two-dimensional or three-dimensional simulation of a market, a product, a seller, a buyer, a transaction, and the like. The digital replica may be viewable on a computer monitor, a television screen, a three-dimensional display, a virtual-reality display and/or headset, an augmented reality display such as AR goggles or glasses, and the like. The digital replica may include one or more graphical components. The digital replica may be configured to be manipulated by a user of the market orchestration system platform 2400. Manipulation by the user may allow the user to view one or more portions of the digital replica in greater or lesser detail. In some embodiments, the digital twin system 2108 may be configured such that the digital replica may simulate one or more potential future states of a market, a product, a seller, a buyer, a transaction, etc. The digital replica may simulate the one or more potential future states of a market, a product, a seller, a buyer, a transaction, etc. based on simulation parameters provided by the user. Examples of simulation parameters include a progression of a period of time, potential actions by parties such as buyers or sellers, increases in supply and/or demand of products, resources, etc., changes in government regulations, and any other suitable parameter for simulation of a market or related to market orchestration.

In some embodiments, the edge device 2192 may be configured to facilitate pre-calculation and aggregation of data for a set of user-configured reports. The user-configured reports may be integrated into the digital replica created by the digital twin system 2108. A user of the market orchestration system platform 2400 may define one or more parameters of the user-configured report to be included in the digital replica. The edge device 2192 may implement one or more data processing and/or filtering according to the parameters of the user-configured report. The edge device 2192 may transmit processed and/or filtered data relevant to the user-configured report parameters to the digital twin system 2108. Upon receiving the processed and/or filtered data, the digital twin system 2108 may create the digital replica including the user-configured report using the received data and present the digital replica to the user.

Referring to FIG. 24, in some embodiments, the edge device 2192 may be configured to collect and process data for use by one or more artificial intelligence (AI) systems. The AI systems 2408 may include the RPA AI system 2406, one or more artificial intelligence systems configured to facilitate creation of the digital replica by the digital twin system 2108, and/or any other artificial intelligence systems connected to and/or included in the market orchestration system platform 2400. The edge device 2192 may be configured to collect and process and/or filter data such that the data is suitable for use by the one or more AI systems 2408. An example of processed and/or filtered data collected by the edge device 2192 for use by the one or more AI systems 2408 is training data for use in training one or more machine learned models.

In some embodiments, the edge device 2192 may be configured to locally store data related to creation of the digital replica by the digital twin system 2108. In cases where the digital replica is related to a particular region, seller, buyer, market, business, etc., the edge device 2192 may be particularly positioned to collect and store data for use in populating the digital replica, for example, by being positioned nearby to the particular region, seller, buyer, market, business, etc. The edge device 2192 may receive, process, filter, organize, and/or store data prior to transmission of the data to the digital twin system 2108 such that the data is relevant to and/or suitable for population of the digital replica. In some embodiments, the edge device 2192 may be configured to organize timing of transmission of data used to populate the digital replica. The edge device 2192 may implement one or more algorithms configured to measure and/or predict congestion of one or more network paths and/or routes and may perform organization of timing of transmission data based on the measurements and/or predictions of the congestion. The edge device 2192 may in some cases prioritize transmission of some types of data over others, such as according to priorities set by a user or by the digital twin system 2108. For example, the edge device 2192 may schedule regular transmissions of low-priority information during evening hours, when congestion is low, and may transmit high-priority information substantially immediately upon receiving the high-priority information and/or receiving a request for the high-priority information. In some embodiments, the edge device 2192 may be configured to select a data protocol for transmission of data used to populate the digital replica. The edge device 2192 may implement one or more algorithms configured to select one or more optimal network paths and/or routes and may select the data transmission protocol based on the measurements and/or predictions of the congestion.

In some embodiments, the edge device 2192 may be in communication with and receive data from a plurality of sensors. The edge device 2192 may be configured to intelligently multiplex alternative sensors among available sensors in a shipping environment for the digital replica.

In embodiments, the intelligent services system 2143 provides a framework for providing intelligence services to the market orchestration system platform 2400. In some embodiments, the intelligent services system 2143 framework may be adapted to be at least partially replicated in the market orchestration system platform 2400. In these embodiments, intelligence service clients, including the market orchestration system platform 2400, may include some or all of the capabilities of the intelligent services system 2143, whereby the intelligent services system 2143 is adapted for the specific functions performed by the market orchestration system platform 2400. Additionally or alternatively, in some embodiments, the intelligent services system 2143 may be implemented as a set of microservices, such that the market orchestration system platform 2400 may leverage the intelligent services system 2143 via one or more APIs exposed to the market orchestration system platform 2400. In these embodiments, the intelligent services system 2143 may be configured to perform various types of intelligence services that may be adapted for different intelligence clients. In either of these configurations, the market orchestration system platform 2400 and/or other intelligence service clients may provide an intelligence request to the intelligent services system 2143, whereby the request is to perform a specific intelligence task (e.g., a decision, a recommendation, a report, an instruction, a classification, a prediction, a training action, an NLP request, or the like). In response, the intelligent services system 2143 executes the requested intelligence task and returns a response to the intelligence service client. Additionally or alternatively, in some embodiments, the intelligent services system 2143 may be implemented using one or more specialized chips that are configured to provide AI assisted microservices such as image processing, diagnostics, location and orientation, chemical analysis, data processing, and so forth.

In embodiments, an artificial intelligent services system 2143 receives an intelligence request and any required data to process the request from the market orchestration system platform 2400. In response to the request and the specific data, one or more implicated artificial intelligence system perform the intelligence task and output an “intelligence response” to the market orchestration system platform 2400.

In embodiments, the market orchestration system platform 2400 may provide access to and/or integrate artificial intelligence system, which may provide access to and/or integrate a robotic process automation (RPA) module. The RPA module may facilitate, among other things, computer automation of producing and validating market orchestration workflows (e.g., transactional workflows, market configuration workflows, regulatory workflows, and many others). The RPA module provides automation of tasks performed by humans, such as reviewing offers (e.g., offers to sell, offers to buy, and many others), researching assets and/or services listed in a marketplace, executing transactions (e.g., approving a set of transactions, shopping, buying, selling, trading, making payments, receiving payments, and many others) and/or otherwise participating in a marketplace (e.g., disapproving a set of transactions, listing items for sale, negotiating with buyers and/or sellers, and the like), managing a financial account and/or digital wallet, identifying assets that could be listed for sale, lease, or the like (e.g., items that have not been used, collectibles that have increased significantly in value, items produced by humans, items produced by 3D printers, and many others), identifying resources that could be listed for sale, lease, or the like (e.g., use of a vacation home, excess energy collected from solar panels, use of an otherwise idle fleet of robots, and many others), identifying the need for an asset and/or resource (e.g., a grocery item, an outfit for an upcoming event, a replacement part for a vehicle, a haircut, and many others), scheduling services (e.g., appointments, reservations, and the like), receiving and reviewing written information, reviewing receipts, entering data into user interfaces, converting or otherwise processing data such as files or records, recording observations, generating documents such as reports or tax filings, communicating with other users by mechanisms such as email, tracking a package, detecting and/or resolving transactional issues (e.g., incorrect amount of money charged, incorrect amount of money received, nonpayment, incorrect items received, damage to received items, partial performance of a service, problems with shipment, fraud, and the like), and many others.

As an example, a user may receive an offer for a transaction, such as a purchase or sale of goods or services. The RPA module may receive the offer on behalf of the user and respond to the transaction based on information regarding how the user has previously responded to similar offers. As a first example, the RPA module may determine whether the user has previously considered similar offers (e.g., by opening or reading a message regarding an offer, or acting on the message, such as following a hyperlink included in the message) or has declined to consider similar offers (e.g., by deleting the message, declining to read the message, or declining to act on the message). Upon receiving an offer that is similar to previous offers, the RPA module may determine that the user may consider the offer and therefore automatically share the message with the user, or determine that the user is unlikely to consider the offer and therefore automatically discard the message. As a second example, the RPA module may determine the steps that a user has previously taken to consider similar offers, such as searching for more information about a product or service associated with an offer, reading third-party reviews of a product or service associated with an offer, discussing the offer with another person, or assessing the user's current inventory or patronage of a product or service associated with the offer. Upon receiving an offer that is similar to previous offers, the RPA module may automatically perform some of the steps that the user has previously taken to aid the consideration of the offer by the user, such as automatically retrieving and presenting to the user some additional information about a product or service associated with the offer, automatically suggesting or initiating a discussion between the user and another person regarding the offer, or automatically notifying the user of the user's current inventory or patronage of a product or service associated with the offer. As a third example, the RPA module may determine the steps that a user has previously taken upon deciding to accept an offer, such as responding to the message, initiating a financial exchange associated with the offer, recording the transaction in a data source, allocating capacity for the good or service associated with the offer, or creating an entry in a calendar regarding a delivery of the good or provision of the service associated with the offer. Upon determining an acceptance of the offer by the user, the RPA module may automatically take some steps to accept or perform the offer, such as automatically responding to the message, automatically initiating the financial transaction, automatically creating a record of the transaction in the data source, automatically allocating capacity for the good or service, or automatically updating the user's calendar to create an entry for the delivery of the good or the provision of the service. In some cases, the RPA module may suggest some of the aforementioned steps to a user, and then perform the steps on behalf of the user upon receiving confirmation from the user. Alternatively or additionally, the RPA module may perform some of the aforementioned steps on behalf of the user without soliciting and receiving confirmation from the user.

In some cases, the tasks involve a workflow that includes a number of interrelated steps, contextual information that relates to the task, and interactions with other applications and humans. The RPA module can be configured to receive or learn one or more such workflows on behalf of the human and in a manner similar to the actions and logic of the human, and can thereafter perform such workflows in response to various triggers such as events. For example, the RPA module can be configured to receive or learn one or more workflows related to approving a transaction (e.g., authorizing payment and the like) on behalf of the human and in a manner similar to the actions and logic of the human in response to receiving an offer for the sale of a set of assets. As a first example, the RPA module may receive, from a user, a request to observe and record a set of steps by which the user receives, considers, accepts, and/or performs an offer for the sale of a set of assets. The RPA module may record the steps performed by the user and replicate the steps upon request of the user in regard to another transaction, or may automatically perform the steps to process another transaction in a similar manner. As a second example, the RPA module may receive, from a user, a set of instructions by which the RPA module can receive, process, and complete a transaction. In some embodiments, the instructions are provided by the user through a no-code or low-code graphical user interface, such as a block-based development environment in which the user arranges a sequence of blocks to specify a sequence of instructions for performing a task associated with an offer. The instructions can comprise a script that can be executed by the RPA module to perform a workflow associated with the task. At the request of the user to process a subsequent offer, the RPA module can perform the instructions of the workflow to process the offer in the manner specified by the user. Alternatively or additionally, upon the occurrence of a condition or trigger involving an offer (e.g., a receipt of the offer through a messaging channel and/or a determination of a personal need of the user for a good or service), the RPA module can perform the instructions of the workflow to process or initiate the offer in the manner specified by the user. As a third example, the RPA module may observe a set of actions taken by a user over a period of time. The RPA module may group one or more actions taken by the user into one or more workflows that are associated with an offer (e.g., a pattern of actions that the user takes in response to a condition or trigger that is associated with an offer). Upon receiving or identifying another offer that is similar to previous offers handled by the user, the RPA module may perform a similar set of actions to process the order.

In some embodiments, the RPA module performs a workflow in cooperation with a human or another workflow. For example, a workflow can include one or more human portions to be performed by a human and one or more automated portions to be performed by the RPA module. In some embodiments, the RPA module can first perform an automated portion and deliver a result of the automated portion to the human so that the human can perform a human portion based on the result. In some embodiments, the RPA module can receive a result of a human portion of the workflow and can perform an automated portion of the workflow on the result of the human portion of the workflow. In some embodiments, the RPA module can perform a first automated portion of the workflow, present a result of the first automated portion to a human for review and validation, and can perform a second automated portion of the workflow based on the review and validation of the result of the first automated portion based on a result of the review and validation by the human. For example, the RPA module may review an offer for sale of an asset and deliver a recommendation to proceed with the asset purchase to the human, and upon transaction authorization by the human, the RPA module may then execute the asset purchase by entering payment information into an application user interface and arrange for delivery of the asset. In some embodiments, the RPA module may coordinate with another person and/or another RPA module to complete a task associated with an offer. For example, in order to complete a transaction on behalf of a user, the RPA module may communicate with a partner, colleague, or team member of the user, such as sending a request to initiate or complete a financial transaction related to the offer. Alternatively or additionally, the RPA module may communicate with another RPA module to initiate or complete a financial transaction related to the offer, such as communicating with another RPA module that can authorize the financial transaction on behalf of a partner, colleague, or team member of the user.

In embodiments, the RPA module may leverage the artificial intelligence system to determine when user approval of a transaction is required. For example, user approval may be necessary for purchases over a threshold amount, for non-routine purchases, for the resale and listing of collectibles, and/or the scheduling of appointments, while user approval may not be necessary for inexpensive purchases, rules-based purchases (e.g., rules specified by the human user), and/or routine purchases. In embodiments, the RPA module can generate an output communicated to one or more users (e.g., a visual notification displayed for a user of a digital twin, a visual notification displayed for a user of a digital wallet, a visual notification displayed for a user of a device (e.g., a mobile device, a wearable, an augmented reality headset, a virtual reality headset, an IoT device, or the like), or a message that is transmitted to a user by a communication channel such as email, text message, or voice output). In embodiments, the output may include a GUI such as to enable the user to approve a transaction.

In some embodiments, the RPA module may use one or more machine learning algorithms to perform one or more steps associated with an offer for a transaction. As a first example, the RPA module may train a machine learning model to learn the steps by which the user receives, considers, or completes transactions that are associated with offers for transactions. In some cases, the RPA module may use a pattern recognition machine learning model to associate a pattern of actions taken by a user with a workflow that the user performs in regard to a particular type of offer. The RPA module may use such a trained machine learning model to receive, consider, or complete a transaction associated with an offer on behalf of the user. As a second example, the RPA module may use a natural-language processing (NLP) machine learning model to understand natural-language communication that is associated with an offer, such as a natural-language description of the offer by a vendor of a product or a service provider of a service, or to evaluate one or more natural-language reviews of a product or service associated with an offer. The RPA module may use information extracted from such natural-language communication in order to receive, consider, or complete a transaction associated with the offer on behalf of the user. As a third example, the RPA module may use a natural-language synthesis machine learning model to generate natural-language communication in order to generate communication with the user or other individuals associated with an offer. For example, the RPA module may suggest, to the user, a natural-language message that can be sent to accept or perform an offer or to communicate with another individual regarding the offer. Upon receiving acceptance by the user, the RPA module may send the natural-language message to another user as part of the consideration, acceptance, and/or performance of the offer. As a fourth example, the RPA module may use one or more control-based machine learning models to perform an offer on behalf of the user. In embodiments, after completing a financial transaction regarding a product, the RPA module may control one or more devices, robots, autonomous vehicles, or the like to receive, deliver, transport, install, configure, and/or use the product on behalf of the user.

In some embodiments, the RPA module may interface with an extended reality (XR) environment, such as an augmented reality (AR) environment or a virtual reality (VR) environment, in order to suggest, evaluate, accept, and/or perform an offer on behalf of a user. As a first example, upon receiving an offer and determining that the offer might be of interest to the user, the RPA module may present an indicator of the offer to the user within the XR environment, such as a location marker to indicate a location where a product or service associated with the offer is available. As a second example, the RPA module may generate, within the XR environment, one or more indicators of information about the offer, such as a depiction of a product or a result of a service (e.g., altering an avatar of the user or another individual to depict the avatar wearing a garment that is associated with the offer, or updating a visual depiction of a virtual environment of the user to include a piece of furniture that is associated with the offer). As a third example, the RPA module may initiate and/or conduct, within the XR environment, an acceptance or performance of a transaction associated with an offer, such as exchanging a virtual currency with another individual, and presenting a depiction or indication of the exchange of virtual currency with the other individual within the XR environment.

In embodiments, the market orchestration system platform 2400 includes a policy engine that allows edge-network aware policy execution for trade instances. The policy engine may be an interface and system configured to enable a user to design, configure, and deploy a set of policies, which can be associated and/or linked to a workload (e.g., execution of a trade, discovery of a counterparty, and the like) such that the workload only completes execution if the set of policies are satisfied. A policy could state, for example, that no trades may be executed with a certain counterparty beyond a threshold volume per day, and trades with that counterparty would execute until the threshold volume value was reached for that day. In trading, and particularly high frequency trading where a trade is determined by an algorithm (i.e., based on a strategy dictated by a trader and/or trading organization), timing can be critical. Latency in communication networks and other IT infrastructure can allow faster traders to front run, which negatively affects outcomes for slower traders. A policy associated with a trading workload could call on an edge device to automatically test a network connection for latency (e.g., from the closest edge node to the IT infrastructure of the exchange) and execute a trading workload only if latency is below a threshold value. Other example policies include counterparty blacklists, counterparty whitelists, asset blacklists, asset whitelists, buying an asset only when the price of that asset is in a specified range, only trading when volatility is below a specific threshold, only trading when market liquidity is above a specific threshold, only trading certain times of day, only trading when likelihood of execution is above a threshold value, and many others.

In embodiments, the market orchestration system platform 2400 may provide access to and/or integrate artificial intelligence system, which may be configured to recognize and/or understand the stage of a marketplace and automatically output a set of control instructions related to configuration of the marketplace based at least in part on the recognized and/or understood stage, including any of the parameters of configuration of the marketplace or any other marketplace parameters noted throughout this disclosure.

In some embodiments, the marketplace stages may be defined by economic cycle theories (e.g., Kondratiev Wave, Elliott Wave Supercycle, and many others).

In some embodiments, the marketplace stages may include the following stages: a new marketplace stage, a growth marketplace stage, a mature marketplace stage, and a distressed marketplace stage. In these embodiments, a new marketplace stage may describe the state of a marketplace that has just been launched. A new marketplace stage may have extremely low transaction activity and/or number of participants. A growth marketplace stage may describe the state of a marketplace where the number of participants and/or the number of transactions are rapidly increasing. A mature marketplace may describe the state of a marketplace where the number of participants and/or the number of transactions have stabilized. A distressed marketplace may describe the state of a marketplace where the number of participants and/or the number of transactions are decreasing.

In embodiments, an artificial intelligent services system 2143 receives an intelligence request and any required data to process the request from the market orchestration system platform 2400. In response to the request and the specific data, one or more implicated artificial intelligence system perform the intelligence task and output a classification (e.g., a classification of a marketplace stage) and a set of control instructions for the market orchestration system platform 2400 based on the classification. In some examples, the set of control instructions for new marketplace stage classifications and/or growth marketplace stage classifications may include deploying an intelligent agent that automatically generates small transactions to maintain transactional activity, deploying an offering engine that orchestrates participation by parties in other similar markets, deploying an engine for dynamically pricing transactions that decreases trading fees, deploying an intelligent agent to promote engagement by low-activity accounts, deploying an engine for automatically discovering and linking offerings from other marketplaces for presentation in the marketplace, deploying an engine for automatically increasing party engagement (such as by incentives for first trades), adjusting various marketplace configuration parameters, and many others. In embodiments, the set of control instructions for mature marketplace stage classifications may include deploying an engine for dynamically pricing transactions that increases trading fees, detecting distribution of executed trades by IP address and/or party relative to a theoretical “fair” distribution to identify competitive execution advantages and apply automated delay to a subset of trades by that address and/or party, deploying an intelligent agent to promote engagement by low-activity accounts, automatically pricing and/or eliminating inactive accounts, deploying a governance engine that dynamically imposes trading limits on parties, adjusting marketplace configuration parameters to optimize marketplace efficiency, deploying a gamification engine to promote engagement by accounts (e.g., reward animations, emphasis on trending assets, lottery incentives, visual and/or auditory feedback rewarding users with color, movement, and sound, badges, haptics, points, rankings, gamified imagery, charms, and the like) and many others. In embodiments, the set of control instructions for distressed marketplace stage classifications may include managing the termination of the marketplace, transforming the marketplace (e.g., by offering a new product or service), and many others.

In some examples, the intelligent services system 2143 may receive data from various sources described throughout this document and the documents incorporated by reference herein and may generate a set of feature vectors based on the received data. The intelligent services system 2143 may input the set of feature vectors into a machine-learned model (e.g., using a combination of simulation data and real-world data) to categorize or classify marketplace stage and generate a set of control instructions based at least in part on the marketplace stage classification by a set of human experts (such as by the user) and/or by the other systems or models. Data sources and feature vectors used for the categorization or classification of marketplace stage and the generation of control instructions may include user activity data, user profile data, transaction data, marketplace age data, as well as external data sources (transaction data relating to similar marketplaces or user data relating to similar marketplaces), and many others. Such artificial intelligence systems used for classification or categorization and/or generation of control instructions, in the present example and other examples described herein, may include a recurrent neural network (including a gated recurrent neural network), a convolutional neural network, a combination of recurrent neural network and a convolutional neural network, or other types of neural network or combination or hybrid types of neural network described herein or in the documents incorporated by reference herein.

Continuing the example, the intelligent services system 2143 may receive an intelligence request and marketplace age data, marketplace participant data, and marketplace transaction data from the market orchestration system platform 2400. In response to the request and the received data, the artificial intelligence system may classify the marketplace as a new marketplace stage and may then, based at least in part on the new marketplace stage classification, output a control instruction to the market orchestration system platform 2400 to use an engine for dynamically pricing transactions to decrease trading fees.

In embodiments, the market orchestration system platform 2400 may provide access to and/or integrate artificial intelligence system, which may be configured to recognize and/or identify indicators of poor health in a marketplace and automatically output a set of control instructions related to configuration of the marketplace based at least in part on the recognized and/or identified indicator(s) of poor health to mitigate the identified issue(s), including any of the parameters of configuration of the marketplace or any other marketplace parameters noted throughout this disclosure.

In some examples, a poor health indicator may include a significantly increasing average time between transactions over time and mitigation may include deploying an intelligent agent that automatically generates small transactions to maintain market activity.

In some examples, a poor health indicator may include an increasing concentration of sales by a particular seller or buyer (i.e., a cornered market), and mitigation may include deploying a governance engine that dynamically imposes trading limits on parties and/or deploying an offering engine that orchestrates participation by parties in other similar markets.

In examples, a poor health indicator may include large amounts of buy-side and sell-side activity by related entities (i.e., churn), and mitigation may include deploying an engine for dynamically pricing transactions that increases trading fees in cases where volume of counter-positioned trades is high.

In examples, a poor health indicator may include the simultaneous selling and buying of the same asset(s) to create misleading or artificial activity in the marketplace (i.e., wash trading), and mitigation may include suspending user accounts of involved entities and/or notifying regulatory authorities.

In examples, a poor health indicator may include the presence of large numbers of inactive or barely active accounts and mitigation may include automatically pricing and/or eliminating inactive accounts, deploying an intelligent agent to promote engagement by low activity accounts, and/or deploying a gamification engine to promote engagement by accounts (e.g., reward animations, emphasis on trending assets, lottery incentives, visual and/or auditory feedback rewarding users with color, movement, and sound, badges, haptics, points, rankings, gamified imagery, charms, and the like).

In examples, a poor health indicator may include an absence of new offerings and mitigation may include deploying an engine for automated discovery and linking of offerings from other marketplaces for presentation in the marketplace.

In examples, a poor health indicator may include an absence of new sellers and/or buyers and mitigation may include deploying an engine for automated party recruitment (such as incentives for first trades).

In examples, a poor health indicator may include an absence of new sellers and/or buyers and mitigation may deploying an engine for automated party recruitment (such as incentives for first trades).

In examples, a poor health indicator may be detected distribution of executed trades by an IP address and/or party relative to a theoretical “fair” distribution (i.e., front running) and mitigation may include applying an automated delay to a subset of trades by the IP address and/or party such as to restore a theoretically “fair” distribution.

In some embodiments, the intelligent services system 2143 receives an intelligence request and any required data to process the request from the market orchestration system platform 2400. In response to the request and the specific data, one or more implicated artificial intelligence system perform the intelligence task and output an identification (e.g., an identified poor health indicator) and a set of control instructions based at least in part on the identification for the market orchestration system platform 2400.

In examples, the intelligent services system 2143 may receive data from various sources described throughout this document and the documents incorporated by reference herein and may generate a set of feature vectors based on the received data. The intelligent services system 2143 may input the set of feature vectors into a machine-learned model (e.g., using a combination of simulation data and real-world data) to identify poor health indicators of a marketplace and to output a set of control instructions by a set of human experts (such as by the user) and/or by the other systems or models. Data sources and feature vectors used for identification of poor health indicators and generation of control instructions may include user activity data, user profile data, transaction data, transaction timing data, marketplace age data, trade distribution data (by party, IP address, or the like), offering data, as well as external data sources (transaction data relating to similar marketplaces or user data relating to similar marketplaces), and many others. Such artificial intelligence systems used for identification and control instruction generation, in the present example and other examples described herein, may include a recurrent neural network (including a gated recurrent neural network), a convolutional neural network, a combination of recurrent neural network and a convolutional neural network, or other types of neural network or combination or hybrid types of neural network described herein or in the documents incorporated by reference herein.

For example, the intelligent services system 2143 may receive an intelligence request and marketplace offering data from the market orchestration system platform 2400. In response to the request and the received data, the artificial intelligence system may generate an identification of a poor health indicator (such as an absence of new offerings) and may then, based at least in part on the identification, output a control instruction to the market orchestration system platform 2400 to deploy an engine for automated discovery and linking of offerings from other marketplaces for presentation in the marketplace.

In embodiments, a “bet-on-anything” prediction marketplace may be configured to enable the trading of instruments related to the occurrence of an event, satisfaction of a condition, or the like. In embodiments, events may include real-world events (e.g., weather, the passage of legislation, the winner of a baseball game, judicial outcomes, and many others) and/or digital events (e.g., the winner of an online chess match, the occurrence of an event in the metaverse, the outcome of a simulation, the outcome of an electronic gaming event, and many others). In embodiments, the prediction marketplace may be governed by smart contracts. In embodiments, the smart contracts may be based on the occurrence of an event, the satisfaction of a condition, or the like. In embodiments, the prediction marketplace may place wagering limits for trades relating to particular events or conditions. In embodiments, the prediction marketplace may generate multiple variations of the same bet, allowing users to increase their bets where wagering limits are in place. In embodiments, users of the prediction marketplace may generate instruments that are the subject of trading. In embodiments, the prediction marketplace may leverage digital oracles to serve as external data providers to the prediction marketplace.

In embodiments, the prediction marketplace includes a system configured to prevent trading on specific topics (e.g., terrorism, crime, war, natural disaster, disease, or the like) and/or leverages intelligent services system 2143 (such as artificial intelligence system, RPA module, and/or NLP module) to prevent trading on specific topics.

In embodiments, the market orchestration system platform 2400 may be configured to provide aggregation services, validation services, valuation services, recommendation services, smart contract services, and/or the like for market orchestration of various classes of distributed and/or underutilized assets, resources, capabilities, services, and the like. For example, such classes may include personal capital, energy resources, used material, used goods, excess finished goods, excess unfinished goods, excess manufacturing capacity, and many others.

In embodiments, the market orchestration system platform 2400 includes a system configured to provide autonomous identification and valuation of a set of inventoried items held by a set of owners.

In embodiments, the market orchestration system platform 2400 includes a system configured to provide autonomous negotiation and contracting for aggregated assets.

In embodiments, the market orchestration system includes a system configured to provide recommendations for value-added upgrades (e.g., manufacturing capabilities).

In embodiments, the market orchestration system platform 2400 includes a system for providing real-time monitoring.

In embodiments, the market orchestration system platform 2400 includes or integrates with a set of edge devices for validation, monitoring, management, or the like of parties, assets, transactions, or the like. Market orchestration of stranded and/or distributed tangible assets may require “trusted” validation and/or authentication for both participants and assets. Validation may help ensure that buyers, sellers, traders, and the like meet financial, legal, regulatory, and other requirements necessary to participate in a particular market. Validation may also help ensure the value of a commodity (such as a raw material), semi-finished goods, finished goods, capabilities (such as a manufacturing capability, a 3D printing capability, or the like), and may others. Validation may also be used to monitor and report participant data that may be analyzed to autonomously facilitate or recommend certain transactions or market opportunities.

In embodiments, validation of market participants and/or assets may be accomplished by biometric authentication, peer and customer reviews, quality measurements, inventory control systems, and many others. For example, biometric authentication could be used to validate the identity of users participating in a sports betting marketplace (such as to validate the age of participants to meet regulatory requirements) or to validate the identity of users participating in a professional services marketplace (such as to validate the credentials of participants). In embodiments, biometric authentication may be accomplished by retina scanners, fingerprinting, facial recognition, voice recognition, and many others. Peer and customer reviews may be used, for example, to validate a supplier of goods or services. In embodiments, peer and customer reviews may be based on satisfaction with contract completion, social media posts, and many others. In embodiments, such peer and customer review data could be gathered using automated satisfaction polling. Quality measurements may be used, for example, to determine the quality of materials produced and/or received. Quality measurements may include tolerance measurements, machine vision observations and/or measurements, image recognition, statistical analysis, certificates of conformity, and many others. Inventory control systems may be used, for example, to track component parts for a product and to report component part inventory as a market orchestration participant. In embodiments, inventory control systems include QR codes, bar scanners, RFID devices, image recognition systems, AI-enhanced inventory control tools, various control software that could utilize SDKs or other means to integrate specially configured modules that enable use of inventory control systems with the market orchestration system platform 2400, and many others. In examples, footage from a drone may be processed by image recognition software to identify excess valuable timber tracts, including the specific tree species and sizes, and the timber tracts may be automatically listed for sale in a marketplace.

In embodiments, systems and methods for validation of market participants and assets (such as by using biometric authentication, peer and customer reviews, quality measurements, inventory control systems, and many others) may be used to generate a measure of risk related to a party, an asset, a transaction, or the like. For example, social media reviews for a business may be analyzed to generate a measure of risk related to transacting with that business.

In embodiments, the market orchestration system platform 2400 may use a machine learning system and/or artificial intelligence system, such as machine learning system and/or artificial intelligence system included in the intelligent services system 2143, for identification of distributed asset classes and capabilities, aggregation of demand and/or supply, provision of transaction recommendations, and many others. More specifically, machine learning and/or artificial intelligence may be used for mining areas of opportunity based on existing or enhanced subscriber capabilities, generating recommendations, generating predictions (e.g., facilitating ad hoc marketplace creation and management by identifying resources to meet predicted needs that could not otherwise be met due to material shortages, logistics constraints, or the like), negotiating, business planning, smart contracting (such as machine-to-machine negotiation and/or smart contracting), and many others.

In embodiments, the machine learning and/or artificial intelligence systems of the intelligent services system 2143 may be integrated or otherwise connected to a gaming engine. For example, the machine learning and/or artificial intelligence systems integrated with a gaming engine may be configured to choose the amount of raw material to be purchased for manufacturing an order, wherein the purchase of certain excess material could be justified because a quantity discount applies and because there is a market opportunity to immediately sell the excess material to a nearby company in an unrelated business sector.

In embodiments, the market orchestration system platform 2400 includes an authentication system for authenticating marketplace participants (e.g., buyers, sellers, regulators, and the like). The level of authentication required may depend on the marketplace attributes. For example, marketplaces for very expensive (e.g., spaceflight reservation), dangerous (e.g., hazardous chemicals), age-restricted (e.g., alcohol), and/or closely regulated products, services, and/or experiences may require extensive buyer and/or seller authentication. In embodiments, the authentication system may use biometric authentication, password-based authentication, two-factor authentication, multifactor authentication, token-based authentication, certificate-based authentication, transaction authentication, computer recognition authentication, CAPTCHAs, single sign-on, and the like to authenticate marketplace participants and other platform users.

In embodiments, the platform includes a market liquidity system for managing marketplace liquidity. In embodiments, the platform may enable high value marketplaces to be combined or bundled with lower value marketplaces to enable liquidity of marketplace activities.

In embodiments, the market orchestration system platform 2400 may support aggregated consumer grouping of unaffiliated consumers based on a confirmed, inferred, and/or predicted product and/or service need. In embodiments, the platform may be configured to identify a product and/or service need, identify consumers in close proximity to one another that have the product and/or service need, identify providers (e.g., service providers, manufacturers, or the like) that are able to fulfill the product and/or service need, and identify a timeline for transaction settlement (e.g., delivery of a product or timing of a service) that would fulfill the product and/or service need of the aggregated consumer group.

For example, if a drought affects a region and water restrictions are imposed, unaffiliated residents of that region may independently begin buying drip irrigation components. The platform may detect this purchasing trend (e.g., through point-of-sale data or the like), identify the parties providing the drip irrigation components most in demand, and configure a bulk purchase of these components for the unaffiliated grouping of residents from the region. The platform may configure the details of such a purchase, including any smart contract terms governing the purchase (e.g., purchase amount, deposit, delivery details, division of product details, and the like). Continuing the example, the delivery could be made to a locker-type storage facility for individuals to retrieve at their own convenience.

### Enterprise Access Layer

In network computing, an access layer generally refers to one or more layers in an information technology infrastructure that provides access to the infrastructure. The overarching purpose of the access layer is to grant a user, for example via a system or a device, access to resources of the infrastructure, such as network resources, storage resources, processing resources, and others. For example, in a wide area network (WAN) environment, a network access layer provides access to the corporate network across wide-area technology, such as Frame Relay, Multiprotocol Label Switching (MPLS), Integrated Services Digital Network, leased lines, digital subscriber lines (DSL) over traditional telephone lines or coaxial cable. Since the access layer provides local and remote access to a network, the access layer may function as a concentration point where remote users (e.g., clients, partners, etc.) meet local users or infrastructure.

Protocols in the access layer provide a means for one or more systems to deliver data to other devices or systems connected to a set of infrastructure, such as by a communication network. For instance, these protocols may provide a means to deliver data from a private network to a public network. In this sense, the access layer may be considered an interface that is public or client-facing while also being private-facing. An access layer's private-facing capability may refer to its ability to receive, translate, and/or communicate data corresponding to private resources (e.g., private digital assets) from a private network, while its public or client-facing capability may refer to its ability to communicate with or provide access to users that are external to the private network (e.g., public market participants). In embodiments, to perform its functionality as a network intermediary, a network access layer may have protocols and systems that understand details about the endpoints for which it is a facilitator. In embodiments, an access layer may include various sublayers, services, modules, and components, operating according to a variety of different protocols, such as to enable access among a wide range of participating entities.

One environment that can utilize the functionality of an access layer is an enterprise. An enterprise generally refers to an organization with a particular overarching purpose, goal, or objective. For instance, a purpose may be to produce and market a particular set of one or more product lines, to undertake a charitable activity, to provide a public service, or other purpose. To achieve its purpose, an enterprise may have a structure that includes various business units, such as executive officers, a board of trustees or directors, divisions, departments, managers and other job roles, facilities and other assets, a wide array of projects, activities, processes and workflows, etc. Some enterprises span multiple business sectors and therefore have business units, such as divisions, that can be dedicated to a particular business sector.

Enterprises, usually by their size and nature, can have a wide array of resources and assets. For instance, their resources may include raw materials, equipment, devices, systems, products (e.g., parts, components, sub-assemblies, assemblies), capital, knowledge, and technology among others. Some examples of knowledge resources include resources that are customer-based (e.g., customer lists or customer transactional history such as order history, contact information, demand frequency, etc.), vender/supplier-based (e.g., suppliers, procurement information, supply transactional history, etc.), process-based (e.g., formulations, procedures such as standard operating procedures, technical data sheets, process reports such as material compliance reports or quality reports, or other memorialized process expertise), and research-based (e.g., research and development information or reports). Enterprise resources may also include human resources, including expertise and knowledge of enterprise personnel and contractors, or personnel and contractors of customers, suppliers, vendors, partners, or the like. Technology resources may include resources such as inventions, trade secrets, designs, proprietary information of the enterprise (e.g., proprietary software or processes), and/or the like.

In some embodiments, some or all of the resources of the enterprise may be represented in some digital form (e.g., a particular file format), such that these resources may undergo management and processing actions such as being copied, edited, shared, transferred, exchanged, updated, recorded, monitored, accessed, extracted, transformed, loaded, compressed, decompressed, deleted, obsoleted or otherwise processed, such as in digital form or between digital form and another form (such as where knowledge of an expert worker or other individual is accessed by querying the worker through a crowdsourcing system). Even resources that have not had a conventional digital format (e.g., physical goods or equipment) may be represented in a digital format. For example, a non-fungible token may be used to represent resources that are not digital. Additionally or alternatively, some aspect of a resource (e.g., a physical good) can be represented as a digital form or via a digital proxy. For instance, a physical resource may have an associated digital certificate of authenticity, proof of purchase, deed, or a title.

Due to the expanding evolution of digital assets, it is inevitable that enterprises demand an efficient and robust manner of managing digital assets. For example, just as enterprises have historically and efficiently engaged in the transaction of physical goods and the logistics involved in those transactions, enterprises will likely need to address similar aspects for digital transactions. Furthermore, with digital assets, there may be different issues that need to be addressed due to the digital nature of these assets when compared to physical assets. For instance, although unauthentic copies of physical goods are feasible, often, depending on the physical good, the energy, expertise, or equipment needed to generate a copy of physical goods can by itself inhibit copying and help promote the authenticity of a physical asset. In comparison, a digital asset may be easier to replicate. For example, computing has predominantly evolved with a particular simplicity to read/write functionality; making digital files/formats in many cases effortless to duplicate often with minimal loss. Ease of duplication can result in complications, such as where a digital asset is copied and widely distributed and some copies are subsequently modified, making it difficult to determine which versions, among many, are valid. Problems of provenance and validity are compounded with the increasing presence of dynamic digital such as smart contracts and dynamic objects, that are serially updated without human intervention through a network, often by linkage to other dynamic objects that are of uncertain provenance.

Another aspect that is different between physical assets and digital assets is interoperability. Interoperability refers to the ability of systems to exchange and use information. For a physical asset, supply chains are typically structured by participating enterprises to facilitate structural interoperability, such as among the component parts of a system, chemical operability, such as among constituent ingredients in a recipe, or the like. For digital assets (such term including physical assets that have a digital component or capability (such as smart devices and systems)), interoperability may have a variety of different issues. For example, having the computing resources to interact with a digital asset may not be cost prohibitive. Therefore, there may be a large number of entities that are able to cooperate with regard to a digital asset. Additionally, the number of entities is fairly elastic because it may quickly increase or decrease depending on the scarcity or demand for the digital asset (e.g., due to its low-cost barrier to entry). Yet a potential outgrowth of the large number of entities that are able to interact with a digital asset is that the access point should have the capability to accommodate for variance between the entities and/or the volume of entities; as a result, communication protocols, authentication protocols, validation protocols, formatting protocols, etc. need to consider the many actors that are able to participate in the digital asset ecosystem.

The management of digital assets and the transactions they involve may also be able to capitalize on their digital ecosystem. That is, the mechanism involved in transactions for digital assets may leverage computing resources to promote optimal transactions. In other words, with digital assets being digital, they are inherently associated with computing resources and therefore a transaction ecosystem can utilize the associated computing capabilities to potentially enhance the circumstances of a transaction involving a digital asset. As an example, it is not uncommon for an asset to have some inventory period where the owner or controller of the asset has the asset available but needs to identify a receiving party and/or terms for the transaction of the asset.

With the computing resources associated with the digital asset or available to the holder of the digital asset, a transactional ecosystem can be configured that can provide autonomy and/or self-promotion for transactions or asset management actions for a digital asset; that is, instead of the manual execution or facilitation of agreements regarding the transactions of digital assets, a transactional ecosystem for the digital asset can automate and/or facilitate one or more phases associated with digital asset transactions. These phases may include a discovery/identification phase that identifies a candidate transaction opportunity involving a digital asset, a diligence/evaluation phase that may evaluate the parameters of the transaction opportunity, a configuration phase that may configure the proposed terms of the transaction (e.g., an exchange rate or a time for the transaction), a negotiation phase that may adjust the terms of the transaction through one or more rounds of negotiation, an execution phase that executes the configured transaction for the digital asset and/or a performance phase that executes performance of one or more actions called for by the terms of the transaction (e.g., delivery of a digital asset to a defined address at a defined time). In this sense, the transactional ecosystem may be capable of self-promoting because the transactional systems can identify candidate transactions for a digital asset without potentially needing human intervention. Although this level of autonomy is feasible, the digital ecosystem may also operate as a hybrid such that certain aspects of the transaction request require some form of authorization prior to automatic execution (e.g., authorization from an external source such as a manual input). Additional aspects of various phases of digital asset transactions, such as relating to counterparty discovery, monitoring of collateral, automation of underwriting, automated negotiation, and many others are described in the documents incorporated herein by reference and are intended to be encompassed herein except where context prevents) and/or direct instruction to perform one or more of the phases associated with a digital asset transaction.

To address the growing demands for effective digital asset ecosystems, the approach described herein may include an enterprise access layer. In some implementations, an “enterprise” access layer refers to a network access layer by which an enterprise may access various digital assets and resources (including various entities described in connection with the transaction platforms and systems described herein and in the documents incorporated herein by reference) that may be involved in a set of transactions (such as bilateral or multilateral transactions involving the enterprise, as well as ones enabled by a set of marketplaces, exchanges or the like with which an enterprise interacts) via a set of network resources. The enterprise may have control (e.g., direct control), management authority, and/or rights to use or access a set of digital assets that are presented to or accessible via the access layer. In embodiments, an enterprise access layer is capable of simplifying transactions for an enterprise (such as reflecting “consumerization”) because it allows an enterprise to interface with multiple markets, marketplaces, exchanges, and/or platforms (e.g., relating to different business segments) through a common point of access.

One advantage of an enterprise access layer is that it may be configured to operate in conjunction with technologies that enterprises deploy in their own environments (i.e., on their private networks, including on-premises and cloud resources and platforms). This may include a wide range of software applications, programs and modules, services and microservices, and the like, including blockchains, distributed ledger technology (DLT), decentralized applications (dApps), intelligent agents, robotic process automation systems, and a wide variety of big data, analytics and artificial intelligence systems. In one non-limiting example, as enterprises deploy DLT and/or dApps, many enterprises will likely want this technology to assimilate with the other systems, structures and workflows of the enterprise.

Throughout an enterprise, different entities may have different roles and responsibilities that can result in varying levels of permission and/or access to enterprise resources. For example, a human resource employee is unlikely to be able to access machinery or equipment of a manufacturing engineer for the same business. Similarly, it is not likely that the manufacturing engineer can access other employee's personnel files like the human resource employee. Based on such differences, technology deployed internally for an enterprise is likely to have some level of permissioning. In embodiments, an enterprise may prefer for the permissioning of technologies like DLTs and dApps to be similar to or aligned with the physical resource access that is customary to a particular role. For example, when a resource is authenticated and stored on an enterprise's blockchain, that human resource employee would not be an authentication stakeholder for an operations-based resource (e.g., a manufacturing resources), or vice versa.

Generally speaking, a permissioned distributed ledger (e.g., a blockchain) refers to a ledger design where the ledger is not open for everyone to participate in a similar manner like a permissionless ledger (e.g., a public blockchain). Rather, a permissioned ledger may be configured such that participants have particular control/access rights. Enterprises may tend to deploy permissioned systems in their private networks to have access safeguards for enterprise resources while public distributed ledgers attempt to be wholly decentralized and allow anyone to participate with the ledger. For example, enterprises may prefer to deploy permissioned systems because these systems can shield sensitive information, ensure member compliance, and ease the rollout of particular, member-level deployments such as updates and reconfigurations.

FIG. 28 is an example of a general structure for an enterprise ecosystem 2800. In embodiments, the enterprise ecosystem 2800 is an ecosystem where marketplace participants 2810 are able to utilize public or third-party services 2820 to interface with an enterprise 2900 via an enterprise access layer (EAL) 3000. In some embodiments, the market participants 2810 may be any entity that interacts with the enterprise 2900, such as buyers, sellers, vendors, suppliers, manufacturers, service providers, partners, distributors, resellers, agents, retailers, brokers, promotors, advertisers, clients, escrow agents, advisors, customers, bankers, insurers, regulatory entities, hosts (e.g., of marketplaces, exchanges, platforms or infrastructure, among others), logistics and transportation providers, infrastructure providers, platform providers, and others (including various entities described elsewhere herein and/or in the documents incorporated by reference herein). As shown in FIG. 28, some market participants 2810 may be buyers 2812 (also referred to as purchasers or customers) when the enterprise 2900 is the asset provider (e.g., the enterprise is the selling, giving, or sharing party). Market participants 2810 may also be sellers 2814 (also referred to as venders or providers) when the enterprise 2900 is the receiving party or asset acquirer.

The EAL 3000 may be configured to interact with the market participants 2810 (and the ecosystem(s) in which they interact) in a variety of ways. For example, the EAL 3000 may be integrated or associated with one or more marketplaces 2822 such that the EAL 3000 functions as its own market participant on behalf of the enterprise 2900. By being associated with potentially numerous marketplaces (e.g., marketplaces that correspond to the type or nature of the enterprise assets), the EAL 3000 can perform complex or multi-stage transactions with enterprise assets (e.g., in a series or sequence of timed stages, simultaneously in a set of parallel transactions, or a combination of both).

In an example of a multi-stage transaction, the enterprise 2900 may perform a sequence of transactions. For example, the sequence of transactions may be for the purpose of acquiring or accessing a resource from another source (e.g., one of the sellers 2814). For instance, the enterprise 2900 demands resource ALPHA. However, the enterprise 2900 may not have any assets that are directly exchangeable for resource ALPHA. Therefore, the EAL 3000 may be configured to recognize how to acquire one or more assets that are exchangeable for resource ALPHA using the available digital assets of the enterprise 2900. To illustrate, the enterprise 2900 may have resources BETA and GAMMA. To acquire resource ALPHA, the EAL 3000 identifies that resource DELTA is directly exchangeable for resource ALPHA. In this example, the EAL 3000 may perform transactions with BETA and GAMMA to acquire DELTA in order to finally acquire resource ALPHA. For instance, the EAL 3000 exchanges resource BETA with a first asset source for resource EPSILON and then is able to exchange both resources GAMMA and EPSILON for resource DELTA from a second asset source. With the acquisition of resource DELTA, the EAL 3000 exchanges resource DELTA with a third asset source for resource ALPHA. Without an EAL 3000, acquiring resource ALPHA may be rather difficult because it demands access to multiple sources (e.g., across multiple marketplaces) and mapping how resources associated with those sources can be leveraged to obtain a target resource. Yet with the EAL 3000 that has access to multiple marketplaces 2822 and marketplace participants 2810, the EAL 3000 can configure and/or execute a transaction sequence or routine that maps how to obtain the target resource (e.g., resource ALPHA). This may occur regardless of relationship between marketplaces 2822 and/or marketplace participants 2810 such that the EAL 3000 may leverage disparate and independent markets to perform a transaction for a target resource. In other words, resource E may be offered or available in a marketplace 2822 that is a different and distinct marketplace 2822 from the marketplace 2822 that offers the target resource, resource ALPHA.

In embodiments, elements of a multi-stage sequence may be conditional, such that a contingent condition must be satisfied in order for a later stage to commence after completion of a prior stage. Conditions may include ones based on pricing, timing, and other transaction parameters.

In addition to marketplaces 2822, the EAL 3000 may interact with marketplace participants 2810 via third-party systems 2824 (some or all of which may be implemented as third-party services). Some examples of third-party systems 2824 include various financial services/systems such as operated by banks, insurers, lending institutions, valuation services, trading services, or escrow services, authentication services/systems, auditing services/systems, security system/services, etc.

In some examples, the market participants 2810 and/or marketplaces 2822 may use or be associated with a storage system 2826 (which may be implemented as a storage service). In some configurations, the storage system 2826 may include an append-only persistent storage system such as a blockchain (e.g., as labelled in FIG. 28). An append-only persistent storage system refers to a storage system that, when storing data, appends blocks of the newest data to be stored to the most recent block previously stored. In this sense, the chain of storage blocks may function as a time sequence, which may be cryptographically secured to form an immutable time sequence. This structure may be advantageous because someone who has access to the storage system may be able to determine a history of data storage transactions with relative ease. A blockchain storage system may be a permissionless storage system that is open to all of its members (e.g., all or some portion of participants 2810 in a marketplace 2822) or a permissioned storage system depending on the nature of the marketplace 2822 or the third-party system 2824 associated with the storage system 2826.

As described previously, the enterprise 2900 may include enterprise devices 2920 (e.g., enterprise equipment such as user devices, on-premises, cloud and other network infrastructure, general and/or specialty processors (e.g., edge processors), internet of things (IoT) and industrial internet of things (IIoT) devices), systems, processes, etc.) that generate, interface, or generally impact enterprise resources 2910. As with the non-enterprise aspect of the enterprise ecosystem 2800 (i.e., the market-participant side 2804 shown in FIG. 28), in some examples the enterprise 2900 includes one or more private append-only storage systems 2940 (e.g., a private blockchain). The storage system 2940 may be considered private in that the enterprise 2900 controls the access and permission for the private storage system 2940. For example, the private storage system 2940 may be only accessible to devices that have access to a private network associated with the enterprise 2900, such as a WAN. In some implementations, the enterprise 2900 has more than one private blockchains in order to tailor to, for example, the organizational structure of the enterprise 2900. For instance, the enterprise 2900 has one private blockchain that corresponds to a storage system for operations or a product-generating portion of the enterprise 2900 and another private blockchain that corresponds to storage systems for administrative portions of the enterprise 2900. As another example, the enterprise 2900 has a single blockchain with a set of sidechains for components or organizational units of its organizational structure.

In addition to a private blockchain, the enterprise 2900 may include a set of enterprise data stores 2930. When compared to a blockchain, a data store refers to a set of data storage types that is not limited to an append-only persistent data storage structure. Rather, an enterprise data store 2930 may be any one or combination of a relational database (e.g., a structured query language (SQL) database), a non-relational database (e.g., a non-SQL database), a key-value store (i.e., a map from keys to values), a full-text search engine, a distributed database, a set of network-attached storage resources, a message queue or other data storage system or service of any of the many types described herein or in the documents incorporated by reference herein.

The data store 2930 may store enterprise data that is obtained from enterprise resources 2910 or from other various data sources 2950 of the enterprise 2900. For example, FIG. 29 depicts that the enterprise 2900 may include internal or private enterprise systems that generate data specific to the enterprise 2900 (i.e., enterprise data). Some examples of these private enterprise systems that at least partially function as data sources 2950 include enterprise resource planning (ERP) systems, customer relationship management (CRM) systems that contain customer-related information, healthcare systems, supply chain systems (e.g., supply chain management (SCM) systems) that include inter-organizational supply chain information, product life cycle management (PLM) systems that include product or service lifecycle information (e.g., data characterizing items, parts, products, documents, product/service requirements, engineering change orders, and quality information), accounting systems, research and development systems, and HR systems, and/or the like.

In some examples, as shown in FIG. 29, the enterprise 2900 includes a set of analytical systems 2960. These analytical systems 2960 may refer to tools deployed by the enterprise 2900 to perform analysis for various processes or systems associated with the enterprise 2900. For instance, an enterprise 2900 may find it pertinent to their operations to perform market analytics (e.g., for advertising, new product development, and/or marketing purposes). Another type of analytics that the enterprise 2900 may perform is demographic analytics. Demographic analytics may aid an enterprise to understand relevant demographic, psychographic, location, behavioral and other information about customers, venders, employees, potential employees, or a target marketplace. For instance, an enterprise 2900 uses demographic analytics to determine how a new product can reach a particular target demographic or how an existing product/service is perceived by various demographics. Additionally or alternatively, to market analytics and/or demographic analytics, the analytical system 2960 of the enterprise 2900 may be configured to perform an array of statistical analysis. This statistical analysis may be used to support many different activities throughout the enterprise 2900 including analytics performed by other systems of the enterprise 2900 or of the analytical system 2960 itself (e.g., supporting the market analytics, the demographic analytics, or any of a wide variety of other analytics described herein or in the documents incorporated by reference herein).

FIG. 28 and FIG. 29 illustrate examples of the EAL 3000. In both of these examples, the EAL 3000 is shown to include a number of EAL systems (also referred to modules or EAL modules) that enable the functionality of the EAL 3000. In some examples, these EAL systems are deployed in a container that is specific to the EAL 3000. When deployed in a container for the EAL 3000, this containerized instance means that the EAL 3000 includes the necessary tools and computing resources to operate (i.e., host) the EAL systems without reliance on other computing resources associated with the enterprise 2900 (e.g., computing resources such as processors and memory dedicated to the EAL 3000). For example, the container for the EAL 3000 may include a set of one or more systems, such as software development kits, application programming interfaces (APIs), libraries, services (including microservices), applications, data stores, and/or processors or the like to execute the functions of the EAL systems that may enable the EAL 3000 to provide enterprise asset transactional management and other functions and capabilities described throughout this disclosure. References herein to “EAL systems” should be understood to encompass any of the foregoing except where context dictates otherwise.

In some implementations, a set of the EAL systems leverages computing resources considered to be external to the EAL 3000 (e.g., separate from computing resources that have been dedicated to the EAL 3000, such as, in embodiments, computing resources shared with other enterprise applications or systems). In these implementations, the set of EAL systems leveraging external computing resources may be in communication with computing resources specific to the EAL 3000. This type of arrangement may be advantageous when one or more of the EAL systems are computationally expensive and would increase the computational requirements for an entirely contained EAL 3000, such as when one or more of the EAL systems causes the EAL 3000 to be a relatively expensive EAL deployment. For instance, an arrangement leveraging external (e.g., shared) systems may be beneficial for EAL systems that are infrequently utilized. To illustrate, a first enterprise may rarely use an EAL system, such as a reporting system. Here, instead of ensuring that the EAL 3000 has the computational capacity to support a reporting system by itself, the enterprise 2900 configures the reporting system to be hosted by and/or supported by computing resources external to the EAL 3000 to deploy a relatively lean form of the EAL 3000 (i.e., an EAL container that does not include resources dedicated to a reporting system or that includes only limited resources dedicated to the reporting system with the capability to access additional, external resources as needed).

In some configurations, the EAL 3000 or a set of the EAL systems leverages computing resources considered to be external to the EAL 3000 for support. An example of this support may be that the EAL 3000 or the set of EAL systems demands greater computing resources at some point in time (e.g., over a resource intensive time period). For instance, greater being more computing resources than a normal or baseline operation state. In this example, for instance, the enterprises resource not dedicated to the EAL 3000 or EAL systems can assist or augment the services provided by some aspect of the EAL 3000. To illustrate, the EAL leverages enterprise resources to assist or augment the performance of analysis, such as managing and/or analyzing governance for health care data associated with clients of a particular enterprise.

In embodiments, the deployment of the EAL 3000 may be configurable. For example, the enterprise 2900 or some associated developer can function as a type of architect for the EAL 3000 that best serves the particular enterprise 2900. Additionally, or alternatively, the deployed location of the EAL 3000 may influence its configuration. For instance, the EAL 3000 may be embedded within an enterprise (e.g., non-dynamically) where it can be specifically configured using various module libraries, interface tools, etc. (e.g., as described in later detail). In some examples, the configuring entity is able to select what EAL systems will be included in its EAL 3000. For instance, the enterprise 2900 selects from a menu of EAL systems. Here, when an EAL system is selected by the configuring entity, a configuration routine may request the appropriate resources for that EAL system including SDKs, computing resources, storage space, APIs, graphical elements (e.g., graphical user interface (GUI) elements), data feeds, microservices, etc. In some implementations, in response to the request, the configuring entity can dedicate the identified resources of each selected EAL system. For instance, the configuring entity associates the dedicated resources to a containerized deployment of the EAL 3000 that includes the selected EAL systems.

Referring specifically to FIG. 28 and FIG. 29, the EAL 3000 includes a set of eight EAL systems. The set includes an interface system 3010, a data services system 3020, an intelligence system 3030, a workflow system 3040, a wallet system 3050 (also referred to as a digital wallet system), a governance system 3060, a permissions system 3070, and a reporting system 3080. It should be noted that even though both FIG. 28 and FIG. 29 include the set of eight EAL systems, the EAL 3000 may include any number of EAL systems (e.g., three systems, five systems, or seven systems, or any other suitable number of EAL systems). Additionally, although particular types of EAL systems are described herein, the functionality of one or more EAL systems is not limited to only that particular EAL system, but may be shared or configured to occur at another EAL system. For instance, in some configurations, some functionality of the wallet system 3050 may be performed by the data services system 3020 or functionality of the governance system 3060 may be incorporated with the intelligence system 3030. In this respect, the EAL systems may be representative of the capabilities of the EAL 3000 more broadly. In embodiments, the set of EAL systems involved in any particular configuration of the EAL 3000 may include any of the systems described throughout this disclosure and the documents incorporated by reference herein, such as systems for counterparty discovery, opportunity mining, automated contract configuration, automated negotiation, automated crowdsourcing, automated facilitation of robotic process automation, one or more intelligent agents, automated resource optimization, resource tracking, and others.

The interface system 3010 is an EAL system that communicates on behalf of the EAL 3000 and/or enables communication with the EAL 3000 by one or more entities, which may include human operators and/or machines. To communicate on behalf of the EAL 3000, the interface system 3010 is capable of communicating with some or all portions of the enterprise 2900 (e.g., enterprise devices 2920, representatives of the enterprise 2900, and/or private storage systems 2940 of the enterprise 2900). In some examples, to communicate with the enterprise 2900, the EAL 3000 is configured with access rights to the private network of the enterprise 2900. With access to the private network of the enterprise 2900, the interface system 3010 can function as a communication conduit to call a system or device of the enterprise 2900 in order to support another EAL system.

Additionally, the interface system 3010 enables there to be a central communication hub that members of an enterprise 2900 may use to engage with functions of the EAL 3000. For instance, a business unit decides to offer an enterprise resource 2910 as a digital enterprise asset that is available to market participants 2810. Here, a member of the enterprise 2900 or an enterprise device 2920 responsible for the enterprise resource 2910 communicates the enterprise resource 2910 to the wallet system 3050 via the interface system 3010.

As a central communication hub, the interface system 3010 may also function as a communication means that the EAL systems use to communicate with endpoints at the enterprise side (e.g., shown as an enterprise-side 2802 in FIG. 28) or the market participant side (e.g., shown as the market-side 2804 in FIG. 28). For example, the interface system 3010 operates in conjunction with the EAL systems of the EAL 3000 to ensure that the interface system 3010 includes the appropriate APIs, links, brokers, connectors, bridges, gateways, portals, services, data integration systems or other means of translating communications (e.g., data packets or data messages) of intra-EAL systems (e.g., between EAL systems) and/or from the EAL systems to an endpoint on either of the enterprise side (e.g., an enterprise device) or market participant side (e.g., a marketplace 2822, the storage system 2826, or marketplace participant 2810). For example, among many others, the interface system 3010 may have an API that the enterprise 2900 uses to receive or to obtain reports from the reporting system of the EAL 3000.

As shown in FIG. 29, the interface system 3010 may include capabilities such as authentication and/or security protocols as a means to enforce who has the ability to use the EAL 3000. For instance, an entity that is able to use to use the EAL 3000 may receive credentials that indicate the entity's access permission(s) with respect to the EAL 3000. These credentials may be login credentials, an authentication token, digitized cards/documents, biometric feature(s), one-time passwords, or any other information that functions as proof that the entity has a right to access the EAL 3000 via the interface system 3010. In embodiments, credentials may be managed by an identity-as-a-service platform or other identity management systems. It is appreciated that authentication of an entity may include authentication of human users and/or to specific devices/software systems that are authorized to interact with the EAL 3000.

In some examples, the credentials issued to an entity are configured to identify the access rights of the entity. When the credentials identify the access rights of the entity, the interface system 3010 may be able to determine the access rights and tailor which portions of the interface system 3010 that the entity can access. In embodiments, the interface system 3010 is capable of restricting portions of various interfaces or communication channels to EAL systems of the EAL 3000 using the information contained or indicated by credentials that have been associated or issued to an entity.

The data services system 3020 refers to an EAL system that performs data services for the EAL 3000. Data services may include data processing and/or data storage. This may range from more generic data processing and data storage to specialty data processing and storage that demands specialty hardware or software. In some examples, the data services system 3020 includes a database manager to manage the data storage services provided by the data services system 3020. In some configurations, the database manager is able to perform management functions such as querying the data being managed, organizing data for, during, or upon ingestion, coordinating storage sequences (e.g., chunking, blocking, sharding), cleansing the data, compressing or decompressing the data, distributing the data (including redistributing blocks of data to improve performance of storage systems) and/or facilitating processing threads or queues, and the like. In some examples, the data services system 3020 couples with other functionality of the EAL 3000. As an example, operations of the data services system 3020, such as data processing and/or data storage, may be dictated by decision-making or information from other EAL systems such as the intelligence system 3030, the workflow system 3040, the wallet system 3050, the governance system 3060, the permissions system 3070, the reporting system 3080, and/or some combination thereof.

In some implementations, the data services system 3020 includes encryption/decryption capabilities that pair with the data processing/storage. For instance, the data services system 3020 may decrypt data when encrypted data is retrieved from its data store(s). In other situations, the data services system 3020 may encrypt data that is being used, processed, and/or stored at the EAL 3000. For instance, the data services system 3020 receives data to be stored, determines that the received data includes one or more characteristics that satisfy an encryption rule, and encrypts the data prior to, during, or after the data is transferred to a storage location. In this respect, the data services system 3020 may receive an encryption or decryption request that specifies data associated with the data services system 3020 and the data services system 3020 is capable of fulfilling the request and providing the encrypted/decrypted data to the requesting entity. The data services system 3020 may be configured to provide symmetrical encryption, asymmetrical encryption, or other suitable types of encryption. Some encryption algorithms that the data services system 3020 may use are Advanced Encryption Standard (AES), Rivest-Shamir-Adleman (RSA), and variations of Data Encryption Standard (DES) (e.g., 3DES), among others. Additionally or alternatively, the data services system 3020 may also perform hashing or other cryptographic functions to verify data that it manages for the EAL 3000.

The intelligence system 3030 of the EAL 3000 functions to provide intelligent functionality to the EAL 3000. Among other aspects, the intelligence system 3030 is a system that the EAL 3000 can utilize for decision-making regarding transactions for enterprise digital assets. For instance, the intelligence system 3030 may recruit and/or coordinate a set of EAL systems (e.g., including enterprise sources) as necessary to provide a set of outputs in response to one or more intelligent requests (i.e., a decision-making request). Some intelligent or decision-making functionality that the intelligence system 3030 is capable of providing includes peer or counterparty discovery (i.e., identifying parties for a transaction, such as one using enterprise assets or assets that are desired to be acquired by or for an enterprise, among others), automated asset allocation and position maintenance (e.g., automated acquisition or disposition of assets to maintain a desired allocation of assets across asset classes, such as to maintain a desired balance of risk and return across the asset classes), automated asset management (e.g., determining which wallets of the wallet system that an available enterprise asset should be associated with), automated transaction configuration (e.g., assembling smart contract and/or smart contract terms for a set of digital asset transactions), automated negotiation of transaction terms, automated settlement (e.g., by execution of on-chain transfers), modeling or analysis of a set of transactions or a transactions strategy, forecasting or predicting asset or transaction parameters (e.g., prices, trading volumes, trading timings, etc.), automated prioritization (e.g., prioritization of transactions among a set of transactions, of assets among a set of assets, of workflows (e.g., prioritizing a set of workflows among others for access to available resources of the EAL 3000), configuration of transaction timing, and/or automated management of a set of policies (e.g., enterprise governance policies, regulatory or legal policies, risk management policies, and others).

In embodiments, the intelligence system 3030 is capable of learning from prior transactions to inform future transactions. To have this learning capability, the intelligence system 3030 may include a set of learning models that identify data and relationships in transactional data, such as transactional training data set consisting of historical training data (which, in embodiments, may be augmented by generated or simulated training data). Models may include financial, economic, econometric, and other models described herein or in the documents incorporated by reference herein. Learning may use an expert system, decision tree, rule-based workflow, directed acyclic workflow, iterative (e.g., looping) workflow, or other transaction model. Some examples of learning models include supervised learning models, unsupervised learning models, semi-supervised learning models, deep learning models, regression models, decision tree models, random forest or ensemble models, and the like. Learning models may use neural networks (e.g., feedback and/or feed forward neural networks, convolutional neural networks, recurrent neural networks, gated recurrent neural networks, long short-term memory networks, or other neural networks described in this disclosure or in the documents incorporated herein by reference). Learning may be based on outcomes (e.g., financial yield and other metrics of enterprise performance), on supervisory feedback (e.g., from a set of supervisors, such as human experts and/or supervisory intelligent agents), or on a combination.

In some examples, the learning models of the intelligence system 3030 may train using enterprise data that relates to transactions for digital enterprise assets. In this case, training data sets may be proprietary to the enterprise. By having enterprise specific training data sets (i.e., with enterprise training examples), the enterprise 2900 learns how to predict transactional behavior with data tailored specifically to the enterprise 2900 and characteristics of its assets (such term including, except where context indicates otherwise, assets controlled by the enterprise as well as other assets that may be involved in the workflows of the enterprise, such as assets being pursued for acquisition, borrowing, lending, or the like). In some examples, the learning models may train first from a larger corpus of training data (e.g., public training data set) and then undergo a fine-tuning process that trains with a specialized data set that is particular to digital enterprise assets. In these examples, the weights or biases that are configured during the first stage of training with the larger corpus may then be fine-tuned or adjusted during the second stage. In some examples, the fine-tuning of the second stage also assists to prune nodes that have low impact on enterprise-specific data that would not have been pruned by solely training with the larger corpus. In other words, the enterprise-specific data of the second stage of training that fine-tunes the model reduces nodes that do not influence (e.g., the probability) a transaction event regarding an enterprise digital asset.

In some configurations, the intelligence system 3030 includes one or more modules that function to gather data for purposes of training a model of the intelligence system 3030. For example, the intelligence system 3030 includes data pipelines that include data that characterizes digital enterprise assets that are available in a wallet system (e.g., the wallet system 3050), data that characterizes historical, current or predicted state/status data about entities involved in enterprise transactions or workflows, data that characterizes historical, current or predicted state/status data about enterprise assets or resources, or the like. In some examples, these modules that function to gather data for purposes of training a model of the intelligence system 3030 gather, derive, or generate training data from information associated with one more EAL systems. For instance, the training data may be governance/compliance information, such as rules, that can be used to develop models that provide decision-making compliance or predictive compliance. In this example, the governance/compliance data may be translated into enterprise-specific data for the second state of training when the governance/compliance data is specific to the enterprise.

In some implementations, each model, module, service, or the like of the intelligence system 3030 may correspond to a particular marketplace 2822 or type of marketplace 2822. For instance, the training data to train a marketplace's specific model may consist of transactional data for that marketplace 2822 or type. By having a model that is specific to a particular marketplace 2822 or type, the model can be capable of predicting transactional information or transactional events for the marketplace 2822 or type. Therefore, the EAL 3000 can leverage the prediction from the model to inform transactional actions for a digital enterprise asset available to the particular marketplace 2822 or type.

In embodiments, the intelligence system 3030 may include search functionality, such as enabling searching for assets within a wallet of the enterprise or searching within other data resources of the enterprises for assets that may be appropriate for inclusion in the wallet. The search function may use similarity algorithms (e.g., k-means clustering, nearest neighbor algorithms, or others) to discover assets that may be of interest by virtue of similarity to other transacted assets and/or ones presented in a wallet. A search algorithm may be trained, such as based on outcomes of transactions or enterprise or user actions, to identify relevant assets for wallet inclusion and or to identify relevant assets within a wallet for a possible transaction. In embodiments, the search functionality may enable recommendations, such as recommendations of assets for inclusion in wallet, for inclusion in a transaction, for presentation, or the like. Recommendations may, in embodiments, be based on algorithms, including clustering and similarity algorithms that recommend similar transactions to similar parties or the like, collaborative filtering algorithms in which users indicate preferences as to types of assets or transactions and based thereon are associated with other similar users whose actions and transactions inform recommendations, deep learning algorithms, that are trained on transaction outcomes, and many others.

In embodiments, the intelligence system 3030 may facilitate prioritization, such as by alignment of functions and capabilities according to a set of prioritization rules, such as rules that prioritize certain enterprise entities (such as particular workgroups), that prioritize certain types of transactions (such as time-sensitive trading versus long-term resource acquisition), or the like. In embodiments, the prioritization rules may be linked to and/or derived from a set of enterprise plans, such as strategic plans, resource plans, or the like. This may include optionally translating a set of strategic or resource goals into a set of priorities that are applied as rules to transactions. In embodiments, prioritization rules are dynamically and automatically updated based on changes to resource plans, strategic plans, or the like by virtue of integration between the intelligence system 3030 and one or more enterprise planning systems. For example, if a resource plan indicates a need to acquire a critical input resource for an operating function, the intelligence system 3030 may prioritize discovery of candidate sources for that resource. As another example, if a strategic plan indicates a need to dispose of an asset to reduce exposure to market volatility, the intelligence system 3030 may prioritize presentation of the asset in wallet or other interface in order to facilitate rapid disposal of the asset.

Additionally, or alternatively, the intelligence system 3030 may be capable of configuring other EAL systems (e.g., via an intelligence service controller shown in FIG. 29). For example, the intelligent functionality of the intelligence system 3030 may provide configuration details or configuration inputs to other EAL systems. When the intelligence system 3030 configures other EAL systems, the intelligence system 3030 enables the EAL 3000 to operate autonomously or semi-autonomously. That is, the EAL 3000 is capable of operating without human intervention (i.e., autonomously) such that the EAL 3000 coordinates, controls, and/or executes transactions regarding digital enterprise assets on its own accord. Configuration itself may be autonomous, such as using robotic process automation (where an agent is trained to undertake configuration based on training on a set of expert configuration actions), by learning on outcomes, or by other learning processes described herein or in the documents incorporated herein by reference.

In some configurations, a set of models of the intelligence system 3030 functions to predict or recommend configurations for other EAL systems of the EAL 3000. That is, each EAL system may have a configuration protocol that includes parameters that enable a respective EAL system to perform a particular function. Here, a model of the intelligence system 3030 may be trained to generate an output that serves as a configuration parameter for an EAL system. In this respect, one or more models of the intelligence system 3030 may be used to generate predictions or recommendations to configure one or more EAL systems to perform a particular transaction for an enterprise digital asset. Prediction of configuration of one EAL system can be used in the configuration of another EAL system, such as to harmonize configurations across the systems (e.g., to allow development of a logical or efficient sequence of transactions that are governed by the respective systems, to allow effective coordination of EAL resource utilization, to avoid conflicts (e.g., where different systems seek to undertake inconsistent actions with respect to the same resource or asset), or the like. Additional examples of intelligence systems and services are described elsewhere in the disclosure.

In embodiments, a workflow system 3040 is another EAL system of the EAL 3000. A workflow system 3040 generally refers to a platform that combines several discrete workflow tools into a single application that automates processes involving machine and/or human tasks (e.g., in a linear sequence). The workflow system 3040 may integrate with other systems (e.g., EAL systems) using APIs or via the interface system 3010. To automate workflow processes, the workflow system 3040 may include workflow definitions, workflow libraries, workflow optimization, and/or workflow management. For example, workflow definitions define the workflows involved with any number of subject processes. For example, a definition sets forth a series of tasks or actions to be performed in a sequential manner to achieve a target end goal. Workflows may be linear (such as involving an invariant sequence of steps), contingent (such as following a decision tree through a series of decision points that depend on inputs, such as defined by a directed, acyclic graph), looping/iterative (such as where steps are repeated until a threshold, goal or other conclusion is met), or a combination of the above. Workflow management tools may provide an infrastructure for the set-up, performance, and/or monitoring of a sequence of tasks that define a given workflow. In some configurations, the workflow system includes a process builder that functions to build an automated process flow based on pre-defined or configured business rules, transaction models, or the like. In some examples, the workflow management includes form(s) designed to automate feedback or to generate dynamic data input from a workflow or task within a sequence of the workflow. In some instances, the workflow management functions as a workflow engine that runs a workflow system and/or makes decisions about the workflow automatically based on workflow rules. That is, the workflow management may execute the process built by a process builder. In some instances, workflows may be associated with policies, such that a policy is attached to and/or embedded into the workflow as a whole, or into individual steps of the workflow. This may include access policies (e.g., which enterprise entities are permitted to view, initiate, modify, terminate, or otherwise interact with workflow), resource utilization policies (e.g., what resources a workflow can access, how and when), prioritization policies (e.g., to resolve competition among workflows for resources), risk management policies, compliance policies, and many others. Policies may include enterprise governance policies, legal or regulatory policies, risk management policies, and many others. In embodiments, policies may also be embedded into or linked to processing nodes of the EAL, such that the processing node of an EAL resource is aware of the conditions under which it may be used, such as contextual conditions (including transaction and market conditions), network status conditions, and many others. In embodiments, workflows or other EAL processes or functions may be automatically governed or managed based on an enterprise resource plan or enterprise strategic plan, such as via linking to, receipt from, or integration with an enterprise resource planning (ERP) system, such as where an EAL process or service only remains available for use within a budgeted or planned level of utilization, or where a process, service, or workflow is prioritized based on a set of priorities embedded in a strategic plan, or the like.

In embodiments, a wallet system 3050 is an EAL system that supports digital transactions. The wallet system 3050 (also referred to as a “wallet” or “digital wallet”) can function in many ways akin to a storage device while also including increased functionality that allows it to interface with other systems (e.g., EAL systems), especially digital or electronic systems. To support digital transactions, in some implementations, the wallet system 3050 is configured to hold or to contain (e.g., store) digital assets, such as enterprise digital assets, such as digital objects, tokens, or the like. In some examples, the wallet system 3050 functions as an index for digital assets such that the wallet system 3050 represents the status of digital assets without having to store them. When used as an index, the wallet system 3050 may point to or reference the actual storage location of the digital asset (such as a bank account, stock exchange, custodial account, blockchain, distributed database, or the like). For instance, a digital asset that is available for exchange in the wallet system 3050 may be actually stored in data storage of the data services system 3020. Here, the wallet system 3050 may include some indication that the digital asset is available for exchange (e.g., an asset availability tag) along with information that the digital asset is stored in the data services system 3020 (e.g., a storage location identifier) so that the digital asset can be retrieved from the data services system 3020 to perform a transaction.

In some configurations, the wallet system 3050 also contains the digitization of identity data. For instance, the wallet system 3050 may hold identity data such as banking numbers, card numbers, coupons, tickets, credentials, tokens, tokenized assets, vital records, biometric data, passwords, private keys, licenses, etc. For the enterprise 2900, this identity data may refer to identity information about the enterprise 2900 or information about one or more parties associated with the enterprise 2900 that is/are responsible for a respective digital asset. For instance, the identity data associated with an asset that is available in the wallet system 3050 identifies information such as the employee at the enterprise 2900 who made the digital asset available (e.g., an employee number or an employee name) or a department or business unit that the digital asset originated from at the enterprise 2900 or who is responsible for the digital asset. Identity data may be associated with an identity management system or service, an identity-as-a-service platform, or the like. Identity data for the enterprise may be managed based on a structure that represents a set of roles, such as an organizational chart, such as represented by a graph structure (optionally stored in a graph database) pursuant to which some roles are governed by other roles. For example, access layer access policies and other capabilities may be based on the position of a role within a hierarchy, such that access and other capabilities for a role that reports to another role are governed by the entity that holds supervisory role. Role-based governance of workflows allows access policies to be implemented based on the enterprise structure and rapidly updated in cases where the structure changes (e.g., a reorganization) or where individuals change roles.

The wallet system 3050 is also capable of managing, associating, or generating various date code information for a digital asset. For instance, the wallet includes a date code that defines the time at which the digital asset was created, a set of date codes for a window of availability for the digital asset, a date code that designates when the digital asset was made available or added to the wallet, etc.

A wallet system 3050 generally includes at least one wallet as a storage resource (e.g., a partitioned container, a set of files, and/or a set of databases) for digital/electronic information. In this respect, a wallet may be software-based and referred to as a software wallet or physical hardware and referred to as a hardware wallet (e.g., a dedicated hardware storage device or location within a hardware device—a hardware wallet). Digital wallets, to some degree, have been used with cryptographic currency systems (also referred to as cryptocurrency). In such cases, a digital wallet may provide or serve as a digital ledger that includes references to the assets that are associated with the wallet, rather than being the actual holder of the asset. For instance, enterprise digital assets may be actually stored on a private storage system associated and/or controlled by the enterprise 2900. Here, if one of these enterprise assets is associated with a wallet (e.g., made available to market participants via a wallet), instead of transferring the digital asset to the wallet during or following the association (e.g., moving the asset to a storage location dedicated to a wallet), the asset may remain in the private storage location while the wallet includes a record (e.g., an entry in a ledger) of the private storage location. In this configuration, the wallet maintains some type of storage address or identifier of the storage location for the asset (e.g., a type of pointer),

In digital transactions (e.g., wallet-based transactions), there does not necessarily need to be any movement of digital assets (e.g., a change of possession to pair with a change of ownership). Rather, the ownership or controlling information associated with a digital asset can change from one owner to another owner using data entry procedures. For instance, when a digital asset is exchanged from a first entity to a second entity, the ownership information associated with the digital asset is changed from the first entity to the second entity. This change may occur by either overwriting the ownership information in data storage (e.g., a database) or by appending data to non-overwriting storage (e.g., adding blocks to sequential blockchain storage, such as in a distributed ledger that maintains transaction records that indicate ownership transfers and other transaction details), in each case akin to deed or title recordation in tangible property, where the deed or title registry is a transaction ledger records a new deed event or record at a later time such that a timeline of the deed events can inform someone as to the changes in ownership over time. A blockchain for digital assets can function similarly such that there is a first block at a first time that indicates that the first entity owned the digital asset and then, when the digital asset is digitally “exchanged,” there is a second block generated at a second time later than the first time that indicates that the second entity owns the digital asset. Accordingly, a query for information related to the digital asset (e.g., ownership information) would return two records that indicate a change of ownership from the first entity to the second entity. In this sense, when the word “exchange (d)” is used with respect to a digital asset, it can mean that the ownership or controlling information of a digital asset is modified without necessarily moving the digital asset in any way. While the asset may remain in place, control may pass to the different owner; for example, an asset may subsequently be managed (e.g., transferred) only by the valid owner who possesses the private key that is needed to initiate a transfer. However, it is also still possible that the “exchange” of a digital asset can encompass some form of digital or physical movement, such as changing the physical storage locations for the digital asset, such as by locating the digital asset in a wallet or other storage location where only the owner of the wallet or storage location has the ability to interact with or transfer the asset.

When the wallet system 3050 creates or initializes a wallet, that wallet may be unique from other wallets in that it has its own set of unique digital keys. In some examples, the wallet system 3050 or another system of the EAL 3000 may generate the set of unique keys for the wallet when the wallet is created or configured. These digital keys can allow the functionality of the wallet to act on behalf of a specific entity (e.g., the enterprise or an enterprise entity, or a set of roles within the enterprise) to perform or orchestrate digital transactions. In other words, to execute a digital transaction such as an ownership change, a unique key associated with wallet signs off ownership to the wallet's address that is dictated by another key (e.g., a key that is cryptographically related to the unique key signing off ownership). In this sense, digital keys are able to serve as ownership attestation such that trust, control, and security is present for a digital transaction. These digital keys may be independent (e.g., completely independent) of other digital protocols and can be generated with or without consideration for particular storage schemes (e.g., agnostic to a particular storage structure like a blockchain or designed for a particular storage structure). Digital keys may be managed by a key management platform, may be based on identity of users (e.g., identities of a set of roles, such as in a hierarchy of roles), and the like.

As an example, with wallets configured for cryptocurrencies, the set of digital keys functions as secure digital codes needed to interact with a blockchain. Here, for instance, the blockchain stores the currency and the wallet uses one or more keys from the set (e.g., a public key) to locate the currency stored on the blockchain that is associated with the wallet (e.g., to locate the currency with the wallet's address). With the location of the currency, the wallet or an entity facilitating the wallet may perform actions using the currency (e.g., exchanging the currency) and authorize those actions with one or more keys from the set. For example, the wallet performs transactions with the assets and records those transactions on the blockchain or some other digital ledger by using the set of keys. In this sense, digital keys can function as an account and/or an identity to authorize the wallet to perform actions (e.g., on behalf of an entity).

In some examples, each wallet is associated with a pair of cryptographic keys as the set of digital keys. In these examples, one key of the pair may be considered a public key while the other key is considered a private key. Here, a public key refers to a cryptographic key (e.g., an alphanumeric string) associated with a particular entity (e.g., a wallet) that is outward facing such that it may be published and shared with other entities to function as a public unique identifier or address for the particular entity. In other words, the public key may be associated with a digital asset to indicate publicly (or to those who can view the digital asset) who or what controls and/or owns the digital asset. In contrast, a private key refers to a cryptographic key (e.g., an alphanumeric string) that is generally associated with the same entity of the public key, but is kept as a secret. Here, instead of an address function like the public key, the private key may serve as a form of digital signature (e.g., like a unique password) that proves that the entity associated with the key has the authorization to perform a transaction. In other words, the holder of the private key can serve as the controller for performing digital transactions.

The public and private key may be linked to each other in that the public key may be generated from the private key. For example, a random number generator (or alphanumeric generator) generates a private key of X length and then, from the private key, a one-way cryptographic function generates the public key. In some implementations, the public key and private key operate in tandem such that the public key provides an address or destination for the private key holder such that a market participant can request authorization of the private key holder to execute a transaction. In some examples, this cooperation is such that the public key assigned to a wallet must match or prove its relation to the private key to authenticate an asset transaction. Here, this matching may be considered a form of verification for the transaction. In these examples, the public key may be able to “match” or exhibit a relation with the private key because the public key has been generated from the private key.

In some configurations, the wallet uses a derivative form of the private key (e.g., a one-way hashing function) as a digital signature to authorize a transaction. Since the private key can authorize transactions on behalf of the owner/controller of a wallet, if a nefarious party obtained the private key, that nefarious party could remove or disassociate all of the assets from a wallet; thus, stealing assets. Therefore, the security of the private key for a wallet can be critical to the security of the assets associated with a wallet. For reasons such as this, it may be advantageous to authorize a transaction with a form (e.g., a cryptographic function) of the private key that indicates that the authorizer (e.g., the entity digitally signing a transaction with the form of the private key) has/controls the private key, but that does not reveal the actual private key to another party.

In some implementations, securing the authorizing key, such as the private key, depends on the security of the wallet itself. This may be the case when management and/or storage of the private key occurs at the wallet. For example, the wallet stores the set of keys including the private key. When a wallet stores the authorizing key, the wallet system 3050 may use a variety of security techniques to secure the authorizing key. For example, the wallet system 3050 may configure the wallet as a custodial wallet or non-custodial wallet. A custodial wallet generally refers to a wallet service where custody or digital possession of the wallet is outsourced to a third-party service who provides security for the wallet (or keys associated with a wallet). In some examples, to generate a custodial wallet, the wallet system 3050 transfers the one or more keys of the set of keys (e.g., the private key) to the custodian service provider. In some situations, custodial services may offer a greater degree of protection because a custodian service provider may have key security expertise. At the same time, the owner of the wallet (e.g., the enterprise 2900) has to trust the custodian with security responsibility. In some configurations, a custodian service provider may be considered the same as or akin to a key management service (KMS).

In contrast, a wallet may be a non-custodial wallet. A non-custodial wallet refers to a wallet that is not outsourced to a custodian service provider. An enterprise may prefer to use non-custodial wallets when, for example, the enterprise lacks trust in a custodial service provider or perhaps foresees there being a risk of censorship (e.g., limiting the type of transactions or transactions generally for some period of time) from a custodian service provider.

In addition to a wallet being custodial or non-custodial, a wallet may also be considered a “hot” wallet or a “cold” wallet. A hot wallet is a wallet that is connected to a gateway to perform transactions. For instance, the gateway is a wide area network (WAN) such as the internet and the hot wallet is a wallet that is connected to the internet. Some examples of hot wallets include web-based wallets, mobile wallets, and desktop wallets. Since a hot wallet is hot or online with the ability to perform transactions, a user of a hot wallet is able to directly issue transactions, for example to a blockchain, in a relatively easy fashion. For this reason, it may be preferable to use a hot wallet for keys that are frequently used for transactions or keys that have low risk of loss (e.g., keys used with only a particular threshold value of assets). Unfortunately, with this ease of use, the keys associated with the hot wallet are generally vulnerable to threat by the mere fact that they exist online (e.g., connected to the internet).

On the other hand, a cold wallet refers to a wallet that is kept off-line or disconnected from a gateway to perform transactions. By being disconnected from a gateway (e.g., the internet), the cold wallet minimizes potential vulnerability attacks. A cold wallet may any storage-capable device that is disconnected or offline from marketplace transactions (e.g., not connected to the internet) including a simple sheet of paper with the keys printed on the paper. When using a set of keys for a transaction that is stored in a cold wallet, the user may temporarily connect the cold wallet to the transaction gateway and provide the necessary keys prior to disconnecting the cold wallet from the gateway. Since a cold wallet is capable of being online, in some instances, what defines the cold wallet is that it is generally offline (e.g., offline a majority of the time) and/or offline at the time when a transaction is requested for an asset associated with the wallet.

In some situations, the user does not connect the cold wallet, but rather accesses the offline keys and transfers them manually or by a transfer operation (e.g., cut and paste) for execution of the transaction. In some configurations, the transfer operation copies the keys from a cold wallet to a hot wallet to perform the transaction. In these configurations, the keys transferred to the hot wallet may be assigned a time of life (e.g., a temporary lifespan to consummate the transaction) when transferred or otherwise undergo a removal procedure following the execution of the transaction such that the hot wallet does not retain the keys. In other configurations, a transaction may use a combination of a hot wallet and a cold wallet. For instance, the transaction is signed entirely on the cold wallet while the hot wallet is used to issue/relay the signed transaction (e.g., to the blockchain). Due to the nature of cold wallets, cold wallets may be better suited for keys that met a certain security threshold (e.g., a security clearance or designated authorization level) or for keys that are infrequently used.

In some examples, whether the wallet system 3050 uses a hot wallet or a cold wallet depends on the value of the asset associated (or to be associated) with the wallet. For instance, the enterprise 2900 may set a threshold asset value for an individual asset that, if exceeded, must be stored in a secure cold wallet rather than a hot wallet. Similarly, if the asset value is below the threshold asset value, the EAL 3000 may associate the asset with a hot wallet. In some examples, whether the wallet system 3050 uses a hot wallet or a cold wallet depends on the cumulative value of the assets that are to be available for a given wallet. In other words, rather than the threshold asset value being a threshold for the value (e.g., estimated value) of a single asset, the threshold dictates when a hot or cold wallet should be used based on the aggregate value (e.g., estimated value) of the collection of assets that are or will be associated with the wallet.

In some configurations, a wallet of the wallet system 3050 has a key backup protocol to safeguard keys and to prevent assets from being inaccessible due to lost or mismanaged keys. In some examples, the type of wallet or value of the set of assets associated with the wallet dictates the key backup protocol for the keys associated with the wallet. Some examples of key backup protocols include: (i) storing a copy of the set of keys in a designated private storage location associated with the enterprise 2900 (e.g., backup on enterprise resources); (ii) having an agent or employee store a copy of the set of keys in a hardware device such as a Universal Serial Bus (USB) or hardware wallet; or (iii) storing a copy of the keys with a key service management (KSM) system (e.g., a third-party provider). As an example, a particular protocol may be associated with a backup level. For instance, a first backup level may be associated with the key backup protocol (i) while a second backup level is associated with the key backup protocol (ii). Therefore, when a backup level for a wallet is satisfied, the key backup protocol associated with the backup level is implemented as the key backup protocol for the wallet. For example, the first backup level is that the estimated value of the set of assets associated with the wallet is greater than X but less than Y. Here, when this is true, the key backup protocol of (i) that has been associated with the first backup level is implemented as the key backup protocol for the wallet. In this situation, the key backup protocol for the wallet is that a copy of the set of keys is stored in a designated private storage location associated with the enterprise 2900.

In some implementations, the wallet system 3050 has the ability to manage and/or to generate a plurality of wallets. Having a plurality of wallets may be advantageous to partition or sandbox some digital assets from other digital assets. In other words, the wallet system 3050 may generate multiple wallets that have specific attributes. When a digital asset is received by the wallet system 3050, the wallet system 3050 is configured to determine a set of attributes of the digital asset and to match the determined attributes to one or more of the plurality of wallets. For instance, a wallet may be dedicated to a particular marketplace or business field. Here, in response to receiving a digital asset that includes attributes that correspond to the particular marketplace or business field, the wallet system 3050 associates the digital asset with the wallet that shares or matches those attributes (e.g., exact match or a fuzzy match) and thus associating the digital asset with the wallet that also corresponds to the particular marketplace or business field.

As an example, the wallet system 3050 receives two digital assets that are designated as available digital assets. Upon receiving each digital asset, the wallet system 3050 determines that the first digital asset has a first set of attributes that define the first digital asset as a corporate bond and the second digital asset has a second set of attributes that define the second digital asset as an insurance policy data set. In this example, the wallet system 3050 determines that the first set of attributes matches or shares the most attributes with attributes defined for a financial asset wallet. Based on this determination, the wallet system 3050 associates the corporate bond with the financial asset wallet. In some implementations, to associate the digital asset with a particular wallet, the wallet system 3050 generates an identifier such as a label or a tag for the digital asset that indicates the wallet that the digital asset has been assigned to. In some examples, by having an associated identifier, digital assets can be stored together regardless of their attributes, but yet also be retrieved or managed based on the identifier.

In some embodiments, a wallet system 3050 may be configured such that a wallet holds another wallet (i.e., a “wallet-of-wallets”), such that in order to access a “child” wallet, an entity must access the “parent” wallet that contains the child. For example, resources managed by a workgroup may be contained in a set of wallets that can be accessed by employees within the workgroup, but only if the manager of the workgroup who controls the parent wallet provides access (such as through a set of keys for the parent wallet). In embodiments, multiple layers of wallets and sub-wallets may be provided in a hierarchy, such as ones containing all assets, all assets of a given type (e.g., financial, cryptocurrency, non-fungible tokens, intellectual property, or the like), assets controlled by a given workgroup, assets related to a particular marketplace or exchange, or the like. A wallet-of-wallets can address the need for multiparty access control within an enterprise, such as where primary control of wallet usage needs to be governed by a supervisor, such as a manager.

In some configurations, the wallet system 3050 also functions as a means for orchestrating digital asset transactions. To orchestrate a digital asset transaction, the wallet system 3050 may be configured to integrate and/or to manage payment processes that are associated with a digital asset transaction. For example, as more enterprises become global or multi-regional market participants (e.g., a multi-regional merchant), it is quite likely that these enterprises need to process localized payments from an exchanging party (e.g., from a client or a customer). For reasons such as this, the enterprise 2900 can integrate with multiple region-specific payment service providers (PSPs) via the orchestration functionality of the wallet system 3050. In embodiments, the orchestration functionality may be used to orchestrate currency acquisitions and sales for a wallet, such as by automatically purchasing or selling a given currency based on an enterprise forecast of the amount of the currency that will be needed to achieve enterprise workflows or processes that will involve the currency. The forecast of currency needs, which may be continuously updated, may be based on a model of anticipated transaction workflows that are predicted based on historical transactions, current conditions (including market prices of items to be bought or sold using a currency), and enterprise plans (e.g., a transaction plan). Automated purchasing and sales may maintain an appropriate balance in the wallet of each currency anticipated to be needed across a set of marketplaces or exchanges. Automation may be enabled by a model or other artificial intelligence, such as using any of the learning and intelligence types described herein or in the documents incorporated herein by reference.

To facilitate a digital asset transaction, there may be several types of payment processes that need to be executed. For example, in some digital asset transactions, the payment processes may include payment authorization, transaction routing, and transaction settlement. In some examples, in order to orchestrate these digital asset transactions, the wallet system 3050 is configured to electronically connect entities involved in these payment processes, such as PSPs, acquirers, and/or banks and to communicate the appropriate information to these entities to facilitate/execute a transaction.

In some implementations, the orchestration of the wallet system 3050 functions to optimize a digital asset transaction. For example, the transaction optimization functions to determine a best payment route to conduct (e.g., send) a digital transaction. This best route may also be referred to as a best or an optimal transaction rail. Here, the best route may depend on the type of digital asset (such as by selecting a transaction route or rail that is compatible with the asset), the volume or size of the digital transaction (such as by selecting a transaction rail that is capable of handling the volume, one that provides a volume-based benefit, such as a discount, credit, or reward, or the like), the format of the digital transaction, the location of the transaction (e.g., the destination of the transaction and/or source of the transaction), the financing of the digital transaction, the cost of the digital transaction (including transaction cost, borrowing cost, processing costs, costs of energy, and the like) and/or the currency involved in the transaction, among others. As an example, an acquirer of a digital asset (e.g., a market participant 2810) may indicate that they desire a particular digital asset that is available in a wallet of the wallet system 3050. In that case, the acquirer may select a digital asset listed or somehow indicated as available to the interested acquirer. Here, the selection may be coordinated by a transaction facilitator (e.g., an e-commerce interface) that facilitates the transaction for the identified digital asset.

In some implementations, in addition to the selection of the digital asset, the acquirer includes or selects details about the transaction for the digital asset. To illustrate, an exchanging party (e.g., one of the buyers 2812, one of the sellers 2814, or the enterprise 2900) may dictate their preferred payment method (e.g., selected from a list of payment methods that the merchant accepts) using the transaction facilitator. In some implementations, the details about the transaction include terms for the transaction, such as transfer terms (e.g., shipping terms), payment terms (e.g., net 30/60/90), interest terms, licensing terms, or other contract terms (e.g., representations and/or warranties). With the transaction details, the wallet system 3050 may be configured to orchestrate the transaction using a payment or transaction gateway. In some configurations, the wallet system 3050 or another system (e.g., a third-party payment system) encrypts/decrypts some portion of the transaction details (e.g., payment information such as card numbers, routing numbers, communication addresses, etc.) prior to or during communication of the transaction detail to a PSP.

In some configurations, the wallet system 3005 configures the transaction details in order to orchestrate a transaction for an enterprise digital asset. When configuring the transaction details, the wallet system 3050 may specify transaction details that represent the interest of the enterprise 2900. In some situations, to represent the interest of the enterprise 2900, the wallet system 3050 generates transactions details by use of one or more models of the intelligence system 3030. For instance, a model of the intelligence system 3030 may be trained using historical enterprise transaction data to generate a recommendation or prediction of transaction details the enterprise 2900 would prefer for a particular enterprise digital asset, which may be further based on current enterprise conditions (including enterprise resource plans, transaction plans, strategic plans, policies, and the like), market conditions, and other contextual information. A recommendation or prediction may be further used to configure a set of instructions to initiate the transaction, which may be automatically initiated or triggered by an authorized entity. To illustrate, for a particular asset, the wallet system 3050 determines a payment method or payment rail for a transaction involving the particular asset. Some examples of payment methods include clearing houses (e.g., Automated Clearing House (ACH)), credit card providers (e.g., MASTERCARD®, VISA®), online payment systems (e.g., PayPal®), Real-time Payment (RTP) Network, blockchains, the Society of Worldwide Interbank Financial Telecommunications (SWIFT), and Single Euro Payments Area (SEPA). The wallet system 3050 may automatically determine which payment method to use based on characteristics regarding the asset (e.g., asset attributes), the parties involved in the transaction, the location of the transaction, and/or the currency of the transaction.

In some implementations, the wallet system 3050 (and/or other EAL systems) may be configured with an awareness for transactions across sets of assets. For example, in some embodiments, the wallet system 3050 may be configured to identify transactions which would be more efficient to combine or divide. For instance, the wallet system 3050 can determine that instead of selling a first asset in a first marketplace and a second asset in a second marketplace, the enterprise 2900 would receive the most value for these assets by bundling the first and second asset together with a third asset and selling these three assets as a package in one of the marketplaces or a third marketplace. Similarly, the wallet system 3050 may combine acquisitions by packaging multiple acquisitions for different enterprise entities or workflows into a bundle, such as to access volume discounts or other rewards. In other cases, unbundling purchases or sales may provide benefits, such as where discounts are offered for new or trial users of a set of marketplaces or exchanges up to a maximum threshold of transaction value. In other words, with the wallet system 3050 being able to track multiple available assets (including ones desired to be acquired) for the enterprise 2900, the wallet system 3050 can likewise leverage combination or disaggregation of assets to engage in complex transactions that benefit the enterprise 2900 more than unmanaged transactions with the assets. As another example, the wallet system 3050 can operate with supply-side knowledge for the enterprise 2900 (e.g., the supply rate for enterprise digital assets) while also tracking current and past demand-side knowledge across multiple marketplaces for assets that have characteristics, properties, or attributes similar to enterprise assets used in historical workflows in order to generate a recommendation, prediction or instruction about further acquisition. This may further include adjusting the recommendation, prediction or instruction based on an enterprise plan, contextual conditions, or the like.

Another transaction detail that the wallet system 3050 is capable of determining is payment details. Here, one type of payment detail that the wallet system 3050 may coordinate or control is the type of currency that is exchanged and/or when the exchange involving an enterprise digital asset occurs using a particular currency. Determining the type of currency or the timing of a transaction with a particular currency may allow the wallet system 3050 to have another approach to optimize value for a transaction. For instance, the value of different types of currencies is capable of fluctuating based on market conditions. That is, conversion rates or exchanges rates may be determined by a floating rate that depends on market forces of supply and demand for foreign exchange or a fixed rate. Due to the fluctuation of conversion rates, the timing of when a transaction occurs can dictate the buying power or selling power of an asset. To illustrate, if the United States Dollar (USD) has an exchange rate greater than one with respect to the British Pound, then the USD, at that time has greater buying power than when the USD has an exchange rate less than one with respect to the United Kingdom Pound. In other words, with a ratio over one, the USD gets a greater return in British Pound than with a ratio less than one. Therefore, if a transaction for a US enterprise 2900 was going to occur in British Pounds (e.g., with a British market participant), the wallet system 3050 may track the conversation rates and/or facilitate the execution of the transaction at a time within a particular transaction window (i.e., a permitted time period to execute the transaction) that is most advantageous to the US enterprise (e.g., when the USD has the greatest buying power). To facilitate such activity, the EAL system may access a set of predictions of currency conversion rates, such as one generated based on market factors, such as economic data for respective jurisdictions, central bank interest rates, and the like.

Additionally or alternatively, the wallet system 3050 may be capable of identifying a marketplace 2822 or a market participant 2810 operating in a specific marketplace 2822 that enables the conversion rate to be favorable to the enterprise 2900. As an example, the wallet system 3050 may have an enterprise digital asset that is available and demanded by a set of candidate marketplace participants 2810 (e.g., that operate in one or more marketplaces 2822). For each candidate marketplace participant 2810 in the set, the wallet system 3050 determines the preferred currency that would be exchanged with that marketplace participant 2810 for the asset and the conversion rate with respect to a particular base currency (e.g., the default or standard currency for the enterprise 2900). Here, the standard currency for the enterprise 2900 generally refers to the currency that the enterprise 2900 typically holds or predominantly uses. For instance, a US company tends to have a standard currency of USD. In response to the determination of the preferred exchange currency and its associated conversion rate, the wallet system 3050 selects the candidate market participant 2810 with the most favorable conversion rate as the marketplace participant 2810 with which to perform the transaction.

In some configurations, with the selected marketplace participant 2810, the wallet system 3050 may then further optimize the transaction by determining an exchange time within a transaction window where the conversion rate is most favorable to the enterprise 2900. In this sense, the wallet system 3050 is not only capable of tuning a transaction to a favorable currency, but also fine tuning the transaction to occur at a time where that currency has a most favorable conversion rate. This therefore may enable a two-stage optimization of the transaction. In other implementations, when the wallet system 3050 identifies a time for the transaction to occur in a particular currency, the wallet system 3050 performs an assurance check to ensure that other currencies have not suddenly become a more valuable transaction currency for the enterprise 2900 due to market fluctuation. If, during the performance of this assurance check, the wallet system 3050 determines that another currency associated with another one of the candidate marketplace participants 2810 has a more valuable conversion rate than the selected candidate marketplace participant 2810, the wallet system 3050 may instead perform the transaction for the asset with the other candidate marketplace participant 2810.

Similar to currency, the wallet system 3050 may perform transactions accounting for other factors, such as environmental factors, market conditions, economic conditions, or weather conditions. For example, if the exchange of a digital asset is associated with a physical good, the wallet system 3050 can coordinate transaction details, such as shipping logistics or the timing of the performance of the transaction, based on influencing factors such as environmental factors, weather factors, and/or political factors. For instance, if the enterprise 2900 is aware that a network is going to be offline for maintenance, the wallet system 3050 can recognize this upcoming event, and adjust transaction details based on the recognition (e.g., schedule the transactions to occur outside the time when the network is offline). Similarly, if a resource or asset needed by the enterprise is subject to consistent seasonal or other periodic variations in price or availability, the wallet system 3050 can coordinate transactions to acquire the resource or asset at a favorable time (such as during an annual promotional event of a supplier). In embodiments, an acquisition or disposition plan of an enterprise, or instructions derived therefrom, may be linked to or integrated with or into the wallet system 3050, such that the wallet system 3050 is configured to optimize, and then execute, a series of transactions that accomplish the plan (acquisition of needed resources and assets and disposition of others) while optimizing timing and other transaction parameters as noted above.

In some examples, the wallet system 3050 links to or is integrated with an e-commerce engine that includes one or more interfaces. These interfaces may refer to software modules that execute on hardware to provide a portal or graphical user interface (GUI) to interact with the wallet system 3050. That is, the GUI may be designed such that the GUI represents the wallets of the wallet system 3050 and the functionality that is accessible to a particular entity interacting with the EAL 3000. In some examples, the wallet system 3050 includes an interface for each type of entity that has access to the EAL 3000. In other words, an entity of the enterprise 2900 may use an enterprise interface of the wallet system 3050 to facilitate the functionality of the wallet system 3050 for enterprise-based activities (e.g., submitting an enterprise asset available or facilitating transaction details on behalf of the enterprise 2900 for an asset). Similarly, the wallet system 3050 may have a marketplace participant interface separate from the enterprise interface that functions to facilitate actions in the wallet system 3050 that are available to the marketplace participant 2810. For instance, the marketplace participant interface may include an e-commerce shopping interface to discover what assets are available for transactions, a checkout interface such as a shopping cart as a means to stage a series of assets for purchase, or the like.

In some implementations, instead of having multiple interfaces, the wallet system 3050 uses a single interface that is capable of identifying a user of the interface and configuring, presenting or rendering a GUI that matches the access and/or wallet activity permissions associated with the user. In this sense, the single interface is capable of restricting a user from accessing or executing the functionality associated with windows, menus, or other GUI elements that are tied to certain wallet-based activities that should not be accessible to a particular user. For instance, the GUI elements may include an identifier that designates the access permissions required to render the element for display. In this instance, at runtime, wallet system 3050 determines the access permissions associated with a user and renders the GUI elements that satisfy or match the determined access permissions. For example, a purchasing manager in charge of acquiring semiconductor chips may be presented GUI elements that display data from market participants who offer them while not being presented with GUI elements for other goods or services. In this respect, regardless of whether the wallet system 3050 uses one or more interfaces, the user experience (UX) of the interface(s) for the wallet system 3050 differs depending on the entity that is using the interface(s), such that GUI elements and their rendering is tied to access controls and permissions for the wallet system 3050.

Although the wallet interfaces are described with respect to an enterprise entity and a marketplace participant 2810, the wallet interfaces are capable of managing access to the wallet system 3050 (e.g., wallets of the wallet system 3050) at a more granular level such that one enterprise entity may have access to some wallets while another enterprise entity may have access to a different set of wallets (e.g., which may include access to at least one of the same wallets). Similarly, a marketplace participant 2810 (e.g., from a first marketplace 2822) may have access to some wallets (e.g., a first set of wallets) while another marketplace participant 2810 (e.g., a second marketplace 2822 different than the first marketplace 2822) has access to a different set of wallets (e.g., which may include access to at least one of the same wallets). In this manner, the access to the wallet system 3050 can be managed not only at the enterprise/non-enterprise level, but also at the entity level.

As illustrated in FIG. 28 and FIG. 29, the EAL systems of an EAL 3000 may also include a governance system 3060. In some implementations, the governance system 3060 is a means to comply with various rules (e.g., laws, regulations, standards, and/or practices) that impact an enterprise digital asset and transactions regarding the enterprise digital asset. These rules may be government-imposed rules (e.g., laws or regulations), industry-imposed rules (e.g., industry standards or specifications), enterprise-imposed rules (e.g., dictated by an enterprise's code of conduct, mission statement, governance purpose), or consumer-imposed rules (e.g., rules dictated by consumer advocacy groups or consumer watchdogs). For instance, some types of assets may have testing standards that have to be met for the asset to be considered an exchangeable asset. In some examples, the governance is market-specific, such that a specific market has requirements that a market participant needs to satisfy in order to participate in the marketplace. Other types of governance include financial governance, legal or regulatory governance, risk governance, ethical governance and custom governance that may be set by a participating party of a transaction and/or an external entity, such as an operator of a marketplace or exchange, a regulatory body or the like. In order to enforce, monitor, and/or track the governance for an enterprise asset, the governance system 3060 may include any number of libraries that include relevant polices, compliance rules or the like for resources, assets or activities of the enterprise 2900. In embodiments, the libraries may include parameters that define or otherwise correspond to certain rules and/or scenarios.

In some configurations, when an enterprise digital asset is made available in the wallet system 3050, the governance system 3060 identifies any governance that is applicable to the asset. Any identified governances may be indicated in information associated with the asset. In some situations, the governance system 3060, besides merely identifying applicable governance, is configured to determine whether the asset complies with the identified governance. Here, for example, if the asset complies with the identified governance, the asset is made fully available to outside marketplace participants 2810 (e.g., via marketplaces 2822). On the other hand, in some implementations, if the asset fails to comply with the identified governance, the asset may be removed from transactional availability.

In some instances, an asset that fails to comply with governance parameters may be offered at some reduction of value that is proportional to the severity of the compliance failure. In some of these instances, an asset that fails comply with governances may be flagged and include information that identifies the failure such that any such failure is conspicuous to a potential customer or investor in the asset. Here, this allows the asset to stay available, but the risk to be borne by the customer or purchaser is displayed in a transparent fashion. In these instances, the governance system 3060 may generate fault-identifying information that includes a disclaimer or the prominent inclusion of contract terms for the transaction.

FIG. 28 and FIG. 29 also illustrate that the EAL 3000 may include a permissions system 3070. In embodiments, a permissions system 3070 may function as a system for the EAL 3000 that assigns, manages, and/or facilitates access controls and permissions for the EAL 3000. In this sense, the permissions system 3070 is capable of performing access control activities for the other EAL systems associated with the EAL 3000. In other words, the permissions system 3070 can be configured to field permission-based or access requests received by any EAL system. For instance, in response to receiving a request to access the wallet system 3050 via a wallet interface, the permissions system 3070 can be informed of the request and determine a set of permissions associated with the requesting entity. Here, once the permissions system 3070 identifies the set of permissions or access controls associated with the requesting entity, the permissions system 3070 may communicate these permissions to the wallet system 3050 to enable the wallet system 3050 to render the appropriate wallet interface for the requesting user.

The permissions system 3070 may be configured to assign one or more permissions to a user of the EAL 3000. A permission generally refers to a rule that defines access to various portions (e.g., functions) of the EAL 3000. Permissions dictate access parameters in order to control who or what is authorized to access resources. Therefore, permissions are traditionally used to secure resources by permitting who, what, when, or how a resource can be utilized. In some examples, the permissions system 3070 uses access controls or access control lists (ACLs) to manage permissions that are associated with various users of the EAL 3000. These access controls may be discretionary access controls (e.g., managed by business stakeholders of the enterprise 2900), mandatory access controls (e.g., access controls that are deployed to comply with required security protocols for a resource), or role-based access controls (e.g., access controls that correspond to a user's role in the EAL 3000).

As shown in FIG. 29, in some examples, the permissions system 3070 is capable of managing (e.g., assigning, modifying, removing) permissions that are privacy-based rules. That is, an enterprise asset managed by the EAL 3000 may pose privacy concerns. For instance, the enterprise asset (e.g., a medical record) may include personal/protected health information (PHI) which dictates who and/or how a user of the EAL 3000 may interact with that asset. To illustrate, an enterprise entity submits an enterprise asset that includes PHI to the wallet system 3050. Here, the entity may include an indication that the asset includes private or sensitive information or the EAL 3000 (e.g., via the wallet system 3050) determines that one or more attributes for the asset indicate that the asset pertains to private or sensitive information. Based on this determination and/or the precise attribute identified, the permissions system 3070 applies one or more permissions that correspond to a privacy rule implicated by the determination or attribute.

In some implementations, a privacy rule may dictate not only what types of users should access an asset, but also if further processing by the EAL 3000 should occur prior to making the asset available for a marketplace participant 2810 (e.g., in a wallet of the wallet system 3050). For instance, certain assets that include sensitive information may trigger a permission that requires the asset or information included with an asset to be encrypted (e.g., prior to availability of that asset). In this instance, the permissions system 3070 determines that the implicated permission for the asset indicates that the asset (or a portion thereof) should be encrypted. In some configurations, the permissions system 3070 generates an encryption request for the data services system 3020 to enable the data services system 3020 to perform its encryption capabilities. The request may include the asset to be encrypted and the type of encryption being requested for the asset.

Besides implicating privacy rules, the permissions system 3070 can also determine that one or more attributes of the asset or characteristics associated with an entity providing the enterprise asset dictate a particular set of permissions. In some implementations, the characteristics or properties (e.g., entity identifiers) associated with an entity inform the permissions system 3070 which set of permissions should be associated with an asset for which the entity is/was responsible. For instance, when an enterprise entity responsible for an asset seeks to make that asset available via the wallet system 3050, the permissions system 3070 may generate a set of permissions for the asset that correspond to characteristics of the enterprise entity. To illustrate, an enterprise entity may have certain access controls with the enterprise (e.g., a particular level of clearance such as security clearance or confidentiality clearance). The permissions system 3070 may identify that the entity is associated with these access controls and generates permissions for the asset at the EAL 3000 that are similar to or match the access controls associated with the entity at the enterprise. For example, each employee of the enterprise may have an employee identifier. The permissions system 3070 may be configured with a reference table that includes the permissions associated with that employee identifier. Using the table, the permissions system 3070 generates a set of permissions for an asset based on the permissions associated with the employee identifier of an employee who submitted the asset to the EAL 3000. In some configurations, there may be another portion of that table or another table that designates which EAL-based permissions correspond to which enterprise permissions such that the EAL-based permissions can mirror or function in a manner similar to the enterprise permissions. As noted above, permissions may be associated with a set of roles that are managed by an identity management system or platform, such that upon a change of role of an employee, the permissions change (such as removing permissions for a departing employee and applying the previous permissions of an employee to the new employee that is taking the same role).

In embodiments, the permissions system 3070 may further be configured as an approval system for an asset transaction; for instance, the permissions system 3070 may receive an asset transaction request (i.e., a request for a transaction involving the asset) and determine whether the requesting entity has the authorization or approval to proceed with and/or execute the transaction of the asset transaction request. To determine whether the requesting entity has the authorization to perform the transaction, the permissions system 3070 may perform some level of diligence on the details of the transaction. This diligence may include: determining whether the requesting entity has authorization to perform the transaction with the underlying asset(s), determining whether the underlying asset has any conflicts that would inhibit the performance of the transaction, determining whether the transaction is in compliance with one or more plans or policies, or the like.

To determine whether the requesting entity has authorization to perform the transaction, the permissions system 3070 may examine whether the requested transaction satisfies transactional terms for the asset. For instance, some assets or transactions may have transaction detail requirements, such as particular contract terms, minimum pricing, delivery conditions, or timing constraints. When an asset transaction request implicates an asset or transaction that has transaction detail requirements, the permissions system 3070 may identify these requirements and determine whether the requirements are satisfied (e.g., whether minimum thresholds are reached, whether limits are exceeded, or the like). In response to the permissions system 3070 determining that requirements are satisfied, the permissions system 3070 may communicate its approval of the transaction (e.g., to the wallet system 3050). On the other hand, in response to the permissions system 3070 determining that the requirements are not satisfied, the permissions system 3070 communicates that the EAL 3000 should decline the transaction (e.g., to the wallet system 3050). In embodiments, the permissions system 3070 may determine a modification of an otherwise non-compliant transaction that would render it compliant and may communicate the modification, such that the EAL 3000 may execute a modified transaction, such as by purchasing a reduced amount of an item or discovering an alternative source of an item that has a lower price to keep a transaction below a transaction spending threshold, modifying a time of execution to satisfy a waiting period, obtaining an additional approval to satisfy permissioning requirements, purchasing offsets or credits to allow a transaction to satisfy a sustainability objective, or the like.

In embodiments, the permissions system 3070 may also be configured to determine whether the underlying asset has any conflicts that would inhibit the performance of the transaction. This may be important because a large enterprise may have a large portfolio of assets. With a large number of available assets, it is possible that one asset transaction request involves the same underlying asset as another transaction request; for example, both assets may be made subject to requests that they be used as collateral for two different loans, where each loan transaction requires a senior claim to the asset in the case of default. As another example, two transactions may require sale of the same asset to two different counterparties. Due to the possibility of such conflicts, the permissions system 3070, upon receiving the asset transaction request, can determine what transactions are pending or have been requested. From the set of transactions that are pending or have been requested, the permissions system 3070 determines whether any transactions of the set have been authorized for the asset specified by the asset transaction request. If a transaction of the set has been authorized for the asset specified by the asset transaction request, the permissions system 3070 may be configured to deny the asset transaction request (e.g., without disclosing the further details regarding the conflict). In some examples, when an asset transaction request is denied, the permissions system 3070 may recommend a similar alternative asset or set of assets as a substitution for the asset. Similarity may be determined by asset type, asset value, or the like. In embodiments, the EAL 3000 may access capabilities of the transaction platform described elsewhere herein or in the documents incorporated herein by reference for automatically determining similarity of assets based on their attributes and for automatically determining an alternative or substitute asset set based on such similarity, such as to recommend or instruct a set of assets to be provided as substitute collateral for a lending transaction and/or as substitute items for a purchase or sale.

In embodiments, the EAL systems of an EAL 3000 may include a reporting system 3080. Generally speaking, the reporting system 3080 functions to provide some level of reporting to or from the EAL 3000, other EAL systems, non-EAL systems, and/or specified entities of an enterprise. For instance, the reporting system 3080 is capable of providing compliance report(s) for one or more assets of the EAL 3000. Here, the type of compliance report that the reporting system 3080 generates may depend on the type of asset to be reported. For instance, a financial asset and a transaction regarding a financial asset may have compliance reporting requirements for accounting or tax purposes. In that regard, the reporting system 3080 generates a compliance report that fulfills the accounting/tax requirements.

Similarly, the reporting system 3080 may be customized to provide different types of reports. For instance, the reporting system 3080 may be configured to generate a fraud report that conveys transactions that were not authorized or that triggered a fraud alert to occur at the EAL 3000. Here, a fraud alert may come from a third party (e.g., PSP) or from another EAL system (e.g., the permissions system 3070). The reporting system 3080 may also be configured to generate financial reports for financial activity at the EAL 3000. Here, the reporting system may compile financial information regarding transactions that have been executed over some designated or customizable period of time. In some implementations, transactions at the EAL 3000 may have legal implications, such as legal or regulatory reporting obligations. In these implementations, the reporting system 3080 may be configured to generate a legal or regulatory report that is setup to identify transactions that implicate a legal condition and to include these identified transactions in the legal report that the reporting system 3080 generates.

In addition to reports like compliance reports, financial reports, and legal or regulatory reports, the reporting system 3080 may also be configured to generate statistical reports that include statistics or metrics regarding the assets managed by the EAL 3000 and/or activity (e.g., transaction activity) of the EAL 3000. Statistical reports may be their own standalone reports or may be integrated into other types of reports generated by the reporting system 3080 (e.g., part of a financial report). Similarly, the reporting system 3080 may generate EAL activity reports that set forth instances of a particular activity or set of activities that are performed at the EAL 3000. For instance, among many other statistics and metrics, an EAL report may include how many times a particular asset or type of asset is queried, how many times an asset or type is included in a transaction request, what assets or types are available in which wallets of the wallet system 3050, volumes of asset transactions (purchases, sales, exchanges, loans), prices of asset transactions, characteristics of parties involved, and many others.

FIGS. 30 and 31 depict different examples of how an EAL 3000 may be implemented. For example, as shown in FIG. 30, instead of being integrated with the enterprise 2900 (e.g., akin to FIG. 29), the EAL 3000 may be integrated with different systems on the market side 2804 of the enterprise ecosystem. To illustrate, FIG. 30 shows a set of EALs 3000a-n that are integrated with a set of marketplaces 2822a-n. When integrated with a particular marketplace 2822, some or all computing resources relied upon for the EAL 3000 may be hosted on the computing resources associated with the marketplace 2822 (e.g., marketplace servers). Alternatively, when an EAL 3000 is integrated into a particular marketplace 2822 there may be portions of the EAL 3000 that remain hosted by enterprise resources to ensure aspects of security and/or privacy for enterprise assets. Referring specifically to FIG. 30, a first EAL 3000a is associated with or integrated with an orchestrated finance marketplace 2822a. A second EAL 3000b is integrated with an orchestrated insurance marketplace 2822b. A third EAL 3000c is integrated with an orchestrated lending marketplace 2822c. A fourth EAL 3000d is integrated with the third-party systems 2824a. An nth EAL 3000n is integrated with an nth orchestrated marketplace 2822n since other types of marketplaces (not shown) can similarly integrate the functionality of the EAL 3000.

In some implementations, the functionality of the EAL 3000 is distributed across market-side systems such that portions of the EAL 3000 that interface with a particular marketplace 2822 are integrated with that marketplace 2822 while other portions of the EAL 3000 that interface with another marketplace 2822 are integrated with the other marketplace 2822. An example of this would be that the financial offerings of the EAL 3000 are integrated with the finance marketplace 2822a as the first EAL 3000a while insurance offerings of the EAL 3000 are integrated with the insurance marketplace 2822b as the second EAL 3000b. In some configurations, the distribution of the EAL 3000 may be such that wallets of the wallet system 3050 are integrated amongst the marketplaces to which they relate. For instance, a wallet that includes financial enterprise assets is integrated with the finance marketplace 2822a and is represented by the first EAL 3000a. On the other hand, a wallet that includes insurance-related enterprise assets (e.g., data sets that may be integrated with insurance policies or contracts) is integrated with the insurance marketplace 2822b and is represented by the second EAL 2800b.

FIG. 30 also illustrates another scenario on the right side of the figure where an EAL 3000n+1 can be a stand-alone system (e.g., a microservice that enterprises leverage). In other words, the stand-alone system is capable of communicating with both the enterprise 2900 and the market-side systems such as the storage system 2826, third-party systems 2824b, and the orchestrated marketplace 2822n+1. As a stand-alone system, the EAL 3000n+1 may be configured such that the resources (e.g., computing resources) that the EAL 3000n+1 relies upon for operation are not hosted by, for example, the enterprise 2900 or the orchestrated marketplace 2822n+1. This may ensure that computing resources that the EAL 3000 may require are not occupied or being consumed by other resources at its host to compromise or somehow hinder the performance of the EAL 3000. That is, if the EAL 3000 shares resources with a system, that sharing may require priority procedures when resources are occupied or time in queue to wait for a particular resource to be available for utilization.

FIG. 31 is an example of the EAL 3000 integrated with the configured market orchestration system 3100 (e.g., similar to a portion of FIG. 30). The configured market orchestration system 3100 may refer to a system that can control and/or manage a market ecosystem. In some respects, the configured market orchestration system 3100 may be considered a “system of systems” because it is a structure that provides cooperative coordination among a set of market-related systems that are configurable for the execution of various market services/tasks. In some examples, the configured market orchestration system 3100 is a system that can function as a liaison for a set of systems or services. For instance, as shown by FIG. 29, the configured market orchestration system 3100 generally includes a configured intelligence service 3110 and configured system services 3120. The configured market orchestration system 3100 may also manage a set of transactional systems 3130. As shown in FIG. 29 some examples of these transactional systems 3130 include an asset valuation system, a collateralization system, a tokenization market system, a market orchestration system, a market making system, and a market governance and trust system. Some of these systems may be variations of the EAL system described previously. For instance, the market governance and trust system may be functionally similar to a combination of the governance system 3060 and the permissions system 3070 of an example EAL 3000. In embodiments, the transactional systems 3130 may be configured for the purpose of generating and/or controlling particular aspects of a market (i.e., transactional execution) while EAL systems may be configured for accessing markets and performing transactions on behalf of an enterprise.

In order to manage the set of transactional systems 3130, the configured market orchestration system 3100 leverages the functionality of the configured intelligence service 3110 and the configured system services 3120. The configured intelligence service 3110 is a framework for providing intelligence services to one or more services, such as the configured system services 3120. In some implementations, the configured intelligence service 3110 receives an intelligence request to perform a specific intelligence task (e.g., a decision, a recommendation, a report, an instruction, a classification, a pattern or object recognition, a prediction, an optimization, a training action, a natural language processing request, etc.). In response, the configured intelligence service 3110 executes the requested intelligence task and returns a response to the intelligence service requestor (e.g., the configured system services 3120).

The configured intelligence service 3110 may include an intelligence service controller 3112 and a set of artificial intelligence (AI) modules 3114. When the configured intelligence service 3110 receives an intelligence request (e.g., from a transactional system 3130 or from the configured system services 3120), the request may include any specific/required data to process the request. In response to the request and the specific data, one or more implicated AI modules 3114 perform the intelligence task and output an “intelligence response.” Examples of responses from AI modules 3114 may include a decision (e.g., a control instruction, a proposed action, machine-generated text, and/or the like), a prediction (e.g., a predicted meaning of a text snippet, a predicted outcome associated with a proposed action, a predicted fault condition, an anticipated state of an entity or workflow relevant to a transaction (such as a future price, interest rate, or conversion rate), and/or the like), a classification (e.g., a classification of an object in an image, a classification of a spoken utterance, a classified fault condition based on sensor data, and/or the like), a recommendation (e.g., a recommendation for an action to optimize a transaction parameter), and/or other suitable outputs of an artificial intelligence system.

There may be a variety of AI modules 3114 associated with the configured intelligence service 3110 to have the broad capability to output the many types of intelligence responses that may be requested of the configured intelligence service 3110. Some examples of these AI modules 3114 include ML modules, rules-based modules, expert system modules, analytics modules (e.g., econometric models, behavioral analytics, collaborative filtering, entity similarity and clustering, and others), automation modules, control system modules, robotic process automation (RPA) modules, digital twin modules, machine vision modules, NLP modules, text-to-speech modules, and neural network modules, as well as any other types of artificial intelligence systems described herein or in the documents incorporated herein by reference and encompassing hybrids or combinations thereof (e.g., where an AI modules uses more than one type of neural network). It is appreciated that the foregoing are non-limiting examples of AI modules 3114, and that some of the modules may be included or leveraged by other AI modules.

As shown in FIG. 31, the AI modules 3114 interface with the intelligence service controller 3112, which is configured to determine a type of request issued to the configured intelligence service 3110 (e.g., from an intelligence requestor such as the configured system services 3120 or a transactional system 3130) and, in response, may determine a set of governance standards and/or analyses that are to be applied by or to the AI modules 3114 when responding to the request. In some examples, the intelligence service controller 3112 may include an analysis management module, a set of analysis modules (e.g., shown as a fraud detection module, a risk analysis module, and a forecasting module), and a governance library.

In some implementations, the analysis management module receives a request from the AI modules 3114 and determines the governance standards and/or analyses implicated by the request. In some examples, the analysis management module may determine the governance standards that apply to the request based on the type of decision that was requested and/or whether certain analyses are to be performed with respect to the requested decision. For example, a request for a control decision that results in the configured system services 3120 configuring an action for the transactional system 3130 may implicate a certain set of governance standards that apply, such as safety standards, legal or regulatory standards (e.g., privacy standards, “know your customer” standards, reporting standards, export control standards and many others), financial accounting regulatory standards, legal standards, quality standards, or the like, and/or may implicate one or more analyses regarding the control decision, such as a risk analysis, a safety analysis, an engineering analysis, or the like. In embodiments, the governance standards may apply to the AI modules; for example, a training data set used for an AI module may be required to satisfy governance standards, such as representativeness of data, absence of bias, adequacy of statistical significance, absence of inequity in resulting outcomes, and the like. As one such example, a training data set of historical transactions used to train an AI module to identify a favorable counterparty may be governed by policy that requires that the training data set include historical transactions that are free of racial, ethnic, or socioeconomic imbalances, compliance analysis, an engineering analysis, or the like.

In some instances, the analysis management module may determine the governance standards that apply to a decision request based on one or more conditions. Non-limiting examples of such conditions may include the type of decision that is requested, a location (e.g., geolocation, jurisdiction, data processing location, network location, or the like) in which a decision is being made, a location in which an activity governed by the decision will be executed (e.g., where an asset or resource will be purchased, stored, sold, or the like), an environment or system that the decision will affect, current or predicted conditions of the environment or system, a set of parties to a transaction affected by the decision, and/or the like. The governance standards may be defined as a set of standards, policies, rules, or the like in a governance library, which may include a set of standards libraries. The foregoing may define conditions, thresholds, rules, recommendations, or other suitable parameters by which a decision may be analyzed. Examples may include, legal standards library, a regulatory standards library, a quality standards library, a financial standards library, a risk management standards library, an environmental standards library, a sustainability standards library, an ethical standards library, a social standards library, and/or other suitable types of standards libraries. In some configurations, the governance library includes an index that indexes certain standards defined in the respective standards library based on different conditions or context. Examples of conditions may be a jurisdiction or geographic area to which certain standards apply, environmental conditions to which certain standards apply, device types to which certain standards apply, materials or products to which certain standards apply, and/or the like.

In some implementations, the analysis management module may determine the appropriate set of standards that must be applied with respect to a particular decision and may provide the appropriate set of standards to the artificial intelligence modules 3114, such that the AI modules 3114 leverage the implicated governance standards when determining a decision. In these embodiments, the AI modules 3114 may be configured to apply the standards in the decision-making process, such that a decision output by the AI modules 3114 is consistent with the implicated governance standards. It is appreciated that the standards libraries in the governance library may be defined by the platform provider, customers, and/or third parties. The standards may be created, managed, promulgated and/or overseen by various sources, such as government standards, industry standards, customer standards, enterprise standards, non-governmental entity standards (e.g., international agencies), or standards from other suitable sources. Each set of standards may include a set of conditions that implicate the respective set of standards, such that the conditions may be used to determine which standards to apply given a situation. In embodiments, the standards may be embodied in executable logic, such that elements of standards are automatically applied, optionally at the level of an individual workload or service within a workflow or system, such as by prompting workload developers to embed standards compliance (and any other policies) into the workload development and deployment process.

In some embodiments, the analysis management module may determine one or more analyses that are to be performed with respect to a particular decision and may provide corresponding analysis modules that perform those analyses to the AI modules 3114, such that the AI modules 3114 leverage the corresponding analysis modules to analyze a decision before outputting the decision to the requestor. In some examples, the analysis modules may include modules that are configured to perform specific analyses with respect to certain types of decisions, whereby the respective modules are executed by a processing system that hosts the instance of the configured intelligence service 3110. Non-limiting examples of analysis modules may include one or more risk analysis modules, econometric analysis modules, financial analysis modules, behavioral analysis modules (e.g., of user behavior, system behavior, or the like), security analysis modules, decision tree analysis modules, ethics analysis modules, forecasting analysis modules, quality analysis modules, safety analysis modules, regulatory analysis modules, legal analysis modules, and/or other suitable analysis modules, including any of the analysis types described herein or in the documents incorporated herein by reference.

In some configurations, the analysis management module is configured to determine which types of analyses to perform based on the type of decision that was requested to be performed by the configured intelligence service 3110. In some of these configurations, the analysis management module may include an index or other suitable mechanism that identifies a set of analysis modules based on a requested decision type. Here, the analysis management module may receive the decision type and may determine a set of analysis modules that are to be executed based on the decision type. Additionally, or alternatively, one or more governance standards may define when a particular analysis is to be performed. For example, the regulatory standards may define what scenarios necessitate a risk analysis. In this example, the regulatory standards may have been implicated by a request for a particular type of decision and the regulatory standards may define scenarios when a risk analysis is to be performed. In this example, AI modules 3114 may execute a risk analysis module and may determine an alternative decision if the action would violate a respective legal standard. In response to analyzing a proposed decision, AI modules 3114 may selectively output the proposed condition based on the results of the executed analyses. If a decision is allowed, AI modules 3114 may output the decision to the requestor. If the proposed configuration is flagged by one or more of the analyses, AI modules 3114 may determine an alternative decision and execute the analyses with respect to the alternate proposed decision until a conforming decision is obtained.

In embodiments, the configured system services 3120 function to configure a set of systems (e.g., the set of transactional systems 3130) corresponding to the configured market orchestration system 3100 to perform a set of services based on intelligence determined for the configured system services 3120. Like configured intelligence services 3110, configured system services 3120 provide data storage, library management, data handling, and/or data processing services that are tailored to requirements associated with a particular market orchestration system 3100 (e.g., in response to data requests and/or directed market transactions by the EAL 3000). In some examples, the configured system services 3120 uses the configured intelligence service 3110 to generate decisions relating to configurations of the set of transactional systems 3130. For instance, if the configured system service 3120 is to configure a smart contract as the configured transactional system, the configured system services 3120 leverages the intelligence of the configured intelligence service 3110 to formulate an intelligence request that will configure some portion of a smart contract (e.g., determine one or more parameter values corresponding to conditions defined in the smart contract).

In some implementations, the systems services that are configured to become the configured system services 3120 are the EAL systems of the EAL 3000. In other words, the configured system services 3120 uses intelligence generated by the configured intelligence services to configure aspects of the EAL 3000, such as the wallet system 3050 or the permissions system 3070. In some implementations, the configured system services 3120 not only configure input or control parameters of EAL systems that perform (e.g., the wallet system 3050) or evaluate transactions (e.g., the permissions system 3070), but also configure input or control parameters that impact the user experience or user interface of the EAL 3000 (e.g., configuration parameters associated with the interface system 3010). Here, since EAL systems may be associated with the configured system services 3120, an EAL system may function via the configured system services 3120 as a requestor for a particular intelligence response.

In some configurations, such as FIG. 31, the configured system services 3120 is capable of performing general system services. These general system services may include operations such as data storage, data processing, networking, etc. that are configured for a particular function or set of functions. As shown in FIG. 31, these general system services may be integrated or controlled by the configured system services 3120. However, in some configurations, it may be more advantageous for the general system services to be more widely available to aspects of the configured market orchestration system 3100. Therefore, the general system services may be its own entity that is accessible to both the configured intelligence service 3110 and the configured system services 3120, but not tethered specifically to the functionality or computing resources of either service.

In some configurations, a configured market orchestration system 3100 is configured for a particular marketplace 2822. As an example, the configured market orchestration system 3100 is configured for a lending marketplace. For instance, the integrated enterprise access layer 3000c of the orchestrated lending marketplace 2822c is a part of a configured market orchestration system 3100 for the orchestrated lending marketplace 2822c. In this example, the configured market orchestration system 3100 via the transactional systems 3130 may perform tasks that may require external information (e.g., current market data) for functions, such as asset valuations, inventory access, business profile management, market analysis, and the like. Depending on the task, subsequent tasks or analyses may be handled (e.g., directly handled) by the configured market orchestration system 3100, by the EAL 3000, or some combination of both.

In some implementations for a configured market orchestration system 3100, the workflow system 3040 of the EAL 3000 can manage or assist in managing one or more of the task-based information exchanges, analyses, and/or transactions by assembling workflow components, identifying pre-existing workflows, or developing workflows based on ML and AI methods. Examples of workflow components include: lookup of an asset serial number to determine a date of manufacture, existing service information, verification of ownership, etc. for the task of asset valuation and collateralization; reviewing business credit rating, claims, customer history, collateral to lending ratio, asset liquidity, etc. for the task of risk evaluation; determining minimum requirements for collateral, min/max allowable insurance for certain asset types, specific asset validation/verification requirements, etc. for the task of regulatory compliance; obtaining bid requests and analyses for the task of evaluation of insurance options and recommendations; and determining transaction type based on customer, client, regulation, etc. for the task of negotiation and completion of transactions.

To illustrate by an example, the workflow system 3040 may generate a set of workflow steps that define a task of a business loan request that proposes the use of machine tools as collateral for a loan to expand business. In this example, a first workflow step may be for the configured market orchestration system 3100 to parse loan application information to identify equipment (collateral) types and characteristics. Here, a second workflow step may be that the configured market orchestration system 3100 submits a preconfigured market-specific request to provide information associated with collateral resale value, liquidity, and market depth, including searches of relevant private or public marketplaces. Here, the EAL 3000 may provide a value range to the configured market orchestration system 3100. A third workflow step may be that the configured market orchestration system 3100 submits a preconfigured market-specific requirement for the EAL 3000 to obtain information associated with the business requesting the loan. In this workflow step, the EAL 3000 may return, for example, credit ratings, outstanding loans, and/or transactions histories. A fourth workflow step may be that the configured market orchestration system 3100 submits a preconfigured market-specific risk analysis request to the EAL 3000 based on government and lender requirements. In some embodiments, this suggested EAL analysis could be automatically selected from a library developed for a type of loan or industry. As an alternative, this fourth workflow step may be completed by the configured market orchestration system 3100 and then verified by the EAL 3000. A fifth workflow step may be based on the internal analyses and/or information provided by the EAL 3000. For instance, in this fifth workflow step, the configured market orchestration system 3100 develops or selects an insurance bid package for submission to market participants. Here, as an example, the configured market orchestration system 3100 may select the best option from among bidders. A sixth workflow step may be that the configured market orchestration system 3100 engages the EAL 3000 to complete the transaction and submit the required documentation. This step may include a series of preconfigured functions selected for bid payment terms and methods, reporting requirements, and the like.

With an EAL configuration, assets of an enterprise 2900 can be natively integrated into marketplaces 2822 without the enterprise 2900 having to necessarily conduct advertising or marketing campaigns. That is, the wallet system 3050 in combination with the interface system 3010 can enable enterprise assets associated with wallet(s) to be readily available to marketplaces 2822. This allows assets of the enterprise 2900 to be market-facing without having to orchestrate product/service offering campaigns. In this respect, the assets can be offered natively on various platforms. Additionally, since the interface system 3010 and/or wallet system 3050 has access to multiple marketplaces, the EAL 3000 can offer assets in marketplaces that are not necessarily the same type of goods/services as the assets, but rather complimentary marketplaces or even marketplaces that are not traditionally offering assets with attributes similar to the available enterprise assets. For instance, an enterprise asset may be a financial asset and yet be offered or integrated into non-financial contexts. To facilitate the market for an asset, in embodiments, a reserve price may be associated with the asset, at which an enterprise is willing to part with the asset if and when it is sought by a market participant in one of the markets in which it can be viewed, such as by the aforementioned via wallet integration.

In some examples, the EAL 3000 allows the securitization and/or tokenization of future revenue streams for the enterprise 2900. Here, an enterprise 2900 can offer assets such as financial history, futures contracts, or other valuable enterprise insights (e.g., as asset-backed tokens) to secure capital or credit in various lending marketplaces. For instance, the enterprise 2900 may request an instant cash advance against the full annual value of the enterprise's subscriptions or source of recurring revenue. This means that the enterprise 2900 can leverage its various assets in traditional or non-traditional lending marketplaces that the EAL 3000 has the capability with which to interface. To illustrate, the EAL 3000 may be configured to translate subscription or recurring payment revenue (e.g., future revenue streams) into instant capital (i.e., cash). For example, the EAL may seek to mitigate risk of a substantive portion of expiring revenue streams and engage the available marketplaces 2822 via the EAL 3000 to access a lender for these future enterprise assets.

In some configurations, to induce or to support lender transactions against future enterprise assets, the lender is able to request other enterprise assets (e.g., proprietary data sets) to form a basis, collateral, escrow, representation, or warranty against the transaction. As one example, the lender may offer a cash advance for future subscription revenue streams of the enterprise 2900 with terms that a new product will launch according to some parameters indicated by enterprise data sets made available to the lender. In situations where the lender executes a transaction based on supporting enterprise data sets, the lender may also receive those enterprise data sets in the transaction, allowing the lender to engage with marketplaces 2822 to sell the enterprise data sets if it so chooses. In this respect, lenders and marketplace participants 2810 transacting with an enterprise can leverage cross market transactions (e.g., as secondary revenue streams to support primary transactions).

In some implementations, when the enterprise 2900 offers its revenue stream as an enterprise asset to secure lending (e.g., an instant cash advance), the result of the lending can be represented digitally by tokenization. In other words, even though the enterprise 2900 has received non-digital currency (e.g., cash), the wallet system 3050 may represent that cash in digital form by means of a token such that the cash can operate as a digital enterprise asset that can participate in digital transactions using the EAL's capabilities. Additionally or alternatively, a smart contract corresponding to the loan/revenue stream may interface with an oracle that receives proof of payment from legacy off-chain systems and that reports verification of the received payment to the smart contract.

By being able to operate in a digital space, the EAL 3000 is able to employ different digital advantages to transactions. For instance, the assets such as operational assets, financial assets, or other assets can utilize tokenization to permit only a particular set of actions by selected stakeholders. The actions permitted by a token can be agreed upon according to consensus mechanisms by a set of stakeholders, or they can be dictated by a governing entity, such as an enterprise manager or executive. In some implementations, because these tokens are functioning to verify agreed upon actions, these tokens may be referred to as “verifiable action tokens.”

In some configurations, the tokenization can occur for any enterprise asset. For instance, certain enterprise assets (e.g., enterprise data sets) may include confidential or private information for (i) individuals associated with the enterprise 2900, (ii) clients of the enterprise 2900, or (iii) confidential information or actions of the enterprise 2900, among others. Enterprise assets that include confidential or private information may be encoded or tokenized (e.g., by the data services system 3020) at the EAL 3000. By encoding the asset or some determined portion thereof, the enterprise 2900 can offer assets relating to or including this information without compromising security, confidentiality, or privacy. In some examples, when tokenizing or encoding some or all of an enterprise asset, the reporting system 3080 generates a report or stores a ledger of these encoded events. By generating such as record, the EAL 3000 can allow the enterprise 2900 to prove compliance or back trace its operations in case of an audit or other request of concern.

In some configurations, the EAL 3000 is able to facilitate transactions for market enterprise resources that may not be traditionally considered as exchangeable assets to the enterprise 2900. It is becoming more common in the age of big data that data sets by themselves can be a valuable asset. For instance, with aspects of artificial intelligence becoming more prevalent, its intelligent capabilities often demand data sets that are used for training, such as to allow the AI to learn to perform some type of task or function. As a large organizational structure, the enterprise 2900 can generate vast amount of data sets regarding its workings (e.g., operations, strategy, planning, sales, marketing, finances, human resource management, etc.) that can be valuable in the training of particular types of AI. For instance, an insurance company may be interested in the occupational conditions of workers that it insures, but finding a large, meaningful data set that characterizes occupational conditions may be rather difficult to find, at least publicly. Yet many enterprises 2900 track or have data regarding their own occupational conditions. In this example, the insurance company would find it valuable to have access to data sets characterizing the occupational conditions of at least the enterprise 2900. The EAL may provide access to such data sets, such as by representing them in a wallet or other system that can be accessed by market participants. Use of the data may be governed by governance and permission systems as noted herein; for example, the data may be permitted to be accessed only in a machine-readable form that is accessible to a neural network or other AI system being trained. In embodiments, portions of the data, such as representing private information, may be anonymized, obfuscated, deleted, redacted, or the like to allow data to be used for training AI while not being used for other purposes. In embodiments, a set of governance policies for the data set may be configured such that the policies are automatically applied to any AI system that is trained using the data; for example, in order to access the training data set, the AI system may be required to demonstrate that it is governed by code or logic that validates that the AI system will be governed in the way required by the policies. As one example, the AI system may be permitted to operate only for a limited purpose, a limited time, in a limited location, by a limited type of party, or the like.

The EAL configuration can allow marketplace participants 2810 to request or to form markets to which the enterprise 2900 may have assets to contribute or from which the enterprise 2900 may wish to obtain assets. For example, an insurance company may request data sets regarding occupational conditions, and the EAL 3000 may parse or receive that request and then determine whether it has the assets available to fulfill that request. When the requested asset is not available at the time of the request, the EAL 3000 may be configured to interface with the enterprise 2900 to present the opportunity to the enterprise 2900 and give the enterprise 2900 the opportunity for fulfillment of the request. In other words, the available enterprise assets may not include an occupational conditions dataset, but when the EAL 3000 presents that request to the enterprise 2900, the enterprise 2900 determines that it can supply one or more data sets to fulfill that request and makes the one or more data sets available as enterprise assets via the wallet system 3050.

In some implementations, “data-as-a-transaction” (e.g., data sets as transacted entities) can contribute to context-based accommodations to transactions between parties. As an example, access to data (e.g., an enterprise asset) could be used by a party to gain advantages in pricing with an acceptance of an increase in risk. For instance, an insurer may allow a partial premium payment based on the delivery by the insured (e.g., the enterprise 2900) of specified data types (i.e., specialized enterprise assets). Here, receipt of the specified data types may automatically trigger a smart contract to adjust or generate one or more terms regarding, for example, pricing, interest rates, conversion rates, deductibles, underwriting requirements, ancillary offerings, promotions, term duration, limits on liability, warranties and representations, etc. To illustrate, a factory of an enterprise may have a liability and workman's compensation policy with some amount of designated coverage. As party of the policy, there may be specified data thresholds regarding, for example, the number of employees on the floor per shift, the number of machine hours of operation per day, the types of machines in operation, the number of sick days, injury reports, and insurance status of employees. When the factory has enough data to satisfy (e.g., surpass or exceed) the specified thresholds, the data may be transferred to the insurer and provisions of the policy affected are adjusted based on the data transferred. For example, the factory sends data (i.e., an enterprise asset) that 83% of its employees are insured. Here, since this 83% exceeds an 80% threshold that allows for a reduction in the policy premium, the transfer of data causes the policy premium adjustment for the factory's policy; in embodiments, the premium may be further reduced if the insurer is permitted to use the data (possibly in anonymized, obfuscated, or otherwise modified form) for its own purposes, such as to facilitate more accurate underwriting or for generation of improved actuarial, economic or predictive models (including predictions of the emergence of insurable risks). In some configurations, the EAL transfers (i.e., a transaction of an enterprise asset) or facilitates the transfer of data along with a protocol request (e.g., a request to adjust the premium). The insurer may also leverage enterprise asset transactions to inform their contracts and policies. For instance, the insurer may generate a query for data from the enterprise (e.g., the factory) to ensure or audit that the conditions of the policy are being met. In other words, the insurer may query or request an enterprise asset transaction for data regarding the number of employees on the floor per shift. Here, if the number increased unbeknownst to the insurer, the query may inform the insurer to adjust the premium (e.g., to increase the premium because the factory has moved to a greater risk level based on the query results for the number of employees on the floor per shift).

When enterprise assets are various types of data sets, the enterprise 2900 may have difficulty understanding the value of a particular data set. For instance, if an insurer would like to purchase data sets for working conditions of the enterprise 2900 to facilitate products or services of the insurer (such as to tailor premium offerings to marketplace participant conditions, to improve underwriting, to improve prediction, or the like), the enterprise 2900 may be unable to properly value this enterprise asset due to its unconventional nature or the mere fact that it is not the type of asset with which the enterprise 2900 is used to dealing. In these situations, the EAL 3000 may request or generate an evaluation marketplace, such as by sourcing (optionally by crowdsourcing) a set of target consumers (e.g., would-be data utilizers) to determine the estimated value for the data set. To generate an evaluation marketplace, the EAL 3000 may invite a set of would-be data providers (e.g., providers who could produce the type of data sets requiring valuation) and/or a set of would-be data utilizers (e.g., target consumers that could demand the types of data sets requiring valuation). In some examples, the parties that accept the invitations become virtual auction participants in order to provide a near-real market valuation of the data sets. That is, the participating would-be data provider posts or submits their data set (e.g., having one or more characteristics similar to the enterprise data set) and the participating would-be data utilizer(s) bid (e.g., propose an estimated value that they would pay) on the posted data set. In some configurations, this bidding process continues for each available data set from the pool of participating would-be data providers. In these configurations, the EAL 3000 may use statistical inference with the plurality of bids for the available data sets to generate a valuation for the similar data set owned by the enterprise 2900. In some examples, the virtual auction house actually performs the offering of the enterprise data set during the auction so that the would-be data utilizers are not biased in their bidding. In embodiments, the EAL may, additionally, or alternatively, facilitate a set of simulations to help assess the value of the data, such as simulations that are informed by historical transactions in data sets having some similarity to available data sets, as well as informed by current marketplace conditions (such as offered prices of other data sets). In some examples, the participants in the virtual auction house engage with the virtual auction for evaluation purposes such that a participant does not receive the enterprise data set, but assists in its valuation for a future market offering. When functioning for a future market offering, it may be advantageous to include a large number of participants to statistically overcome potential bidding biases.

In some situations, following the valuation (such as using a virtual auction house, simulation, or other approached noted above), the EAL 3000 enables the enterprise 2900 to further adjust the valuation of the data set. For instance, the EAL 3000 generates a feedback request to the enterprise 2900 to authorize the estimated value assigned to the data set and the enterprise 2900 provides a message in response to the feedback request that either approves the valuation or adjusts the valuation in some manner. Here, this adjustment feedback loop allows the enterprise 2900 to determine if the valuation justifies the offering of the data set or if the enterprise 2900 would prefer to offer the data set at a higher or lower transactional value compared to the valuation. For example, the value of the data set to the owner (i.e., the enterprise) may differ from the value of the data set to the market. Depending on the disconnect or gap between the owner value and the market value, the enterprise 2900 may adjust the transaction value accordingly. Similarly, being informed by the valuation can also enable the enterprise 2900 to opt out of offering the data set.

In some configurations, the EAL 3000 controlled by an enterprise 2900 receives a data set from the enterprise 2900. Here, the data set may characterize one or more attributes associated with a group of resources privately controlled by the enterprise 2900. For instance, the data set may characterize information about a group of employees of the enterprise 2900 (e.g., factory workers) or a group of equipment (e.g., production equipment of the enterprise 2900). Upon receipt of the data set, the permissions system 3070 determines whether the data set satisfies a set of permission criteria. The permission criteria may refer to criteria that indicate a set of privacy rules, access rules, security rules, compliance rules, or other rules applicable to assets, resources or other entities that are controlled by the enterprise 2900. The enterprise 2900 or its agent may configure these rules or generate the rules to correspond to industry/legal standards (e.g., dictated by the governance system 3060), such as of acceptable privacy (e.g., to abide by the Health Insurance Portability and Accountability (HIPPA) Act or General Data Protection Regulation (GDRP)), or the like.

Depending on the determination of whether the data set satisfies the set of permission criteria, the permissions system 3070 may perform different operations. For instance, in response to the data set failing to satisfy the permission criteria, the permissions system 3070 may communicate the data set to the data services system 3020. In embodiments, the permissions system 3070 recognizes that the data set needs further data processing and cooperates with the data services system 3020 of the EAL 3000 to perform that processing. In these configurations, the further processing may be that the data services system 3020 generates an encoded data set that satisfies the privacy or other rules identified by the permissions system 3070 for the data set. With the encoded data set that complies with the rules identified by the permissions system 3070, the EAL 3000 converts the encoded data set to an exchangeable digital asset. This conversion may occur by the EAL 3000 publishing the encoded data set to the wallet system 3050 and configuring the interface system 3010 with access to the encoded data set in the wallet system 3050 such that market participants 2810 can access and/or request transactions for the encoded data set. On the other hand, if the permissions system 3070 determined that the data set satisfies the permission criteria, the EAL 3000 may convert the data set to an exchangeable digital asset in the same manner without the data processing encoding operation. In embodiments, encoding operations may include embedding applicable rules, such as licensing terms and conditions, for use of the data set, such that upon subsequent use of the data set such rules are automatically applied (e.g., to limit the number of seats that can access the data, to monitor and govern the number of queries or other restrictions permitted, to limit access to sensitive data contained in the data set (e.g., to allow aggregate queries but to limit queries from which private information can be deduced), to limit the location of use, to limit duration of use, to govern which systems or types of systems can access the data, or the like).

In embodiments, the EAL 3000 may be set up to operate as a data plane and control plane for the enterprise 2900. In embodiments, when operating as a data plane, the EAL 3000 may be configured to exchange assets privately-generated by an enterprise 2900 or enterprise entity that operates it. When configured in this manner, the EAL 3000 may receive an asset request from a requesting entity, such as a market participant 2810 with access to the EAL 3000 (e.g., via the interface system 3010). Here, the asset request indicates an asset that may be available for transaction, such as discovered in a wallet system 3050 (e.g., is associated with a wallet of the wallet system 3050) or other presentation interface. Based on the request, the permissions system 3070 identifies whether there are any asset controls (e.g., access controls or permissions assigned to an asset) associated with the requested asset. Here, the permissions system 3070 may have configured the asset control for the asset to indicate a control parameter that must be satisfied prior to any transactional action occurring for the asset. In some examples, the intelligence system 3030 is able to determine control parameters for the permissions system 3070 using data derived from the enterprise 2900 that privately generated the asset. In other words, the intelligence system 3030 can predict or determine a control parameter based on historical data modeling of controls for assets of the enterprise or for controls of assets similar to the assets of the enterprise.

In response to the permissions system 3070 identifying an asset control condition associated with the requested asset, the permissions system 3070 proceeds to determine whether the asset control condition is satisfied, such as, for example, by one or more parameters of the asset requests and/or by one or more attributes of the requesting entity. For instance, the asset control may designate what type of entity is able to access the asset or some set of requirements that must be met by the asset request and/or requesting entity to gain permission to access the asset (e.g., perform a transaction with the asset). In response to the asset control condition being satisfied, the EAL 3000 may facilitate fulfillment of the asset request. On the other hand, if the permissions system 3070 determines that the asset control condition is not satisfied, the requesting entity/asset request is denied. In some configurations, denial of the request generates a message that indicates the denial. This message may include some amount of information detailing the reasons for denial and/or prompting modifications in the asset request and/or requesting entity that would enable the request to be satisfied.

In some implementations, the EAL 3000 receives an asset request from a requesting entity (e.g., a market participant 2810) where the asset request indicates an asset that is available in the wallet system 3050 as an exchangeable digital asset. In these implementations, exchangeable digital assets of the enterprise 2900 correspond to one or more assets stored in a private data structure (e.g., a private blockchain) associated with an owner of the exchangeable digital assets (e.g., the enterprise 2900). Based on the request, the EAL 3000 identifies whether there are any asset controls (e.g., access controls or permissions assigned to an asset) associated with the requested asset. Here, the permissions system 3070 may have configured the asset control for the asset to indicate a control parameter that must be satisfied prior to any transactional action occurring for the asset. Similar to the prior discussed configurations of the EAL 3000, the intelligence system 3030 is able to determine control parameters for the permissions system 3070 using data derived from the enterprise 2900 that privately generated the asset.

In response to the EAL 3000 (e.g., the permissions system 3070) identifying an asset control associated with the requested asset, the permissions system 3070 proceeds to determine whether the asset control is satisfied by at least one of the asset requests or by the requesting entity. For instance, the asset control designates what type of entity is able to access the asset or some set of requirements that must be met by the asset request and/or requesting entity to gain permission to access the asset (e.g., perform a transaction with the asset). In response to the asset control being satisfied, the EAL 3000 may facilitate fulfillment of the asset request. Yet here, fulfillment of the asset request includes storing the asset in a public append-only data structure (e.g., a public blockchain) to represent a transaction involving the asset with the requesting entity. On the other hand, if the permissions system 3070 determines that the asset control fails to be satisfied, the requesting entity/asset request is denied and a denial message (as previously discussed) may be communicated to the requesting entity. With this approach, the EAL 3000 is able to function as a facilitator or executor for transactions that demand operations on both a private data structure (e.g., a private blockchain) and a public data structure (e.g., a public blockchain).

In some examples, the EAL 3000 receives a set of assets generated or controlled by the enterprise 2900. For each asset of the set of assets, the EAL 3000 may classify (e.g., using the intelligence system 3030) the respective asset into an asset category, which may include classifying the asset into an asset control category. Here, each asset category is associated with a set of rules, such as assets controls, that dictate one or more transaction parameters for the exchange of the respective asset with a third party (e.g., a market participant 2810). Moreover, for each asset of the set of assets, the EAL 3000 (e.g., using the permissions system 3070) may assign the set of asset rules for the access category classified by the EAL 3000 for the respective asset. In these examples, the EAL 3000 then converts the set of assets to exchangeable digital assets by publishing the set of assets to the wallet system 3050 and configuring the interface system 3010 with access to the set of the wallet system 3050. In embodiments, asset categories may be associated with a defined set of marketplaces, exchanges, or other environments in which assets may be transacted, such that a set of rules appropriate for the classified asset may be derived by reference to the governing rules of the applicable transaction environment; for example, assets classified as commodities may be governed by rules of a commodities exchange, assets classified as securities may be governed by rules of a securities exchange, assets classified as cryptocurrencies may be governed by rules of a cryptocurrency exchange, and the like. Asset classification may be learned using any of the artificial intelligence or learning techniques described herein, such as on a training data set of historical transactions (e.g., by observing which type of asset objects are traded in which environments), by training on human classification interactions (such as tagging of assets), and the like. Training may be seeded or assisted by a model, such as an asset classification model that classifies or clusters assets based on data object parameters. This may include a hierarchical model or graph with classes and subclasses of asset types.

In some embodiments, the EAL 3000 may also function as a type of monitoring system. For example, the EAL 3000 may be configured to automatically monitor or mine for potential deals or transactions that could involve the enterprise assets that it manages and/or to monitor or mine for opportunities to acquire assets that it wishes to acquire. In some configurations, the EAL 3000 monitors (e.g., via its interface system 3010) a plurality of market participants 2810. While monitoring the plurality of market participants 2810, the EAL 3000 may receive an indication that a monitored market participant 2810 requests or offers an asset candidate or type of asset. In the case of a request for an asset or type, the EAL 3000 determines (e.g., via using the intelligence system 3030) whether the asset candidate matches (or is similar to) an asset available in the wallet system 3050 associated with the EAL 3000. If the asset candidate does not match any available assets in the wallet system 3050, the EAL 3000 may continue to perform monitoring services for other asset candidates. In the case of offers, the EAL 3000 may receive an indication of the parameters of an offer of a digital asset or type, compare the offer to a set of desired transaction parameters, and, if the parameters are satisfied, initiate a transaction to acquire the asset.

In response to a request matching an asset available in the wallet system 3050, the EAL 3000 may be configured to perform a set of operations that further analyze whether to engage or to offer to engage in an asset transaction with the monitored market participant 2810. These operations may include identifying a set of asset control conditions managed by the permissions system 3070 of the EAL 3000 and determining whether a transaction (e.g., a digital exchange) with the monitored market participant 2810 satisfies an asset control criterion corresponding to the asset available in the wallet system 3050 (i.e., the matching asset). For instance, the asset control criterion may indicate that a threshold number has been exceeded. In response to determining that the transaction with the monitored market participant 2810 that involves the asset available in the wallet system 3050 satisfies any asset control criteria (e.g., does not violate a threshold), the EAL 3000 may generate a message data packet that proposes an actual transaction with the market participant 2810 involving the asset available. In some examples, the interface system 3010 communicates the message data packet on behalf of the EAL 3000 to the market participant 2810.

In embodiments, an EAL 3000 may be configured as a multi-tenant EAL 3000, where the functions and capabilities of the EAL 3000 are made available to more than one enterprise (or to more than one business unit of an enterprise), such that processing resources and facilities (e.g., data centers and network infrastructure), operating resources (such as personnel), and others are shared across tenants, while the functions and capabilities of the EAL 3000 are governed and executed with awareness of the access rights and other attributes of each tenant. For example, two (or more) enterprises may share an EAL 3000, such as where the enterprises operate in a similar domain and/or undertake similar transactions, such that the marketplaces, exchanges, or other transactions with which the EAL 3000 are similar for the two enterprises. The EAL 3000 may monitor usage of each tenant, provision resources (such as according to relative priorities), maintain separation of enterprise-specific elements (e.g., wallets of each enterprise), handle billing transactions for usage, and the like. In embodiments, transactions across multiple tenants may be aggregated to achieve volume discounts, with discounts being automatically allocated and applied according to a set of rules (such as based on proportionate contribution to transactions, or the like). In embodiments, tenancy may be managed in a set of tiers, such as with each tier having a set of service levels associated therewith, such as enabling usage of given sets of functions and capabilities of the EAL 3000, setting relative prioritization (e.g., with higher tiers being given priority where transactions are limited, where resources are limited, or the like), and the like.

In embodiments, the EAL 3000 may be configured for peer-to-peer connectivity among a set of enterprises (e.g., bilateral connectivity or multilateral connectivity), such that the functions and capabilities of the EAL 3000 are configured to handle the particular types of assets, resources, workflows and transactions that occur among the enterprises. For example, a bank and a manufacturing entity may establish a peer-to-peer EAL 3000 for a set of financial transactions, including working capital loans, trade credit lending, handling of deposits, payroll processing, payments processing, and others. In this example, the assets of the manufacturing enterprise may be presented in a wallet in the EAL 3000 that is on accessible to the manufacturing entity and to lending officers of the bank, such that the lending assets can be configured to be used as collateral for lending transactions. For example, the EAL may facilitate automated generation of sets for collateral for a set of loans among the manufacturing enterprise and the bank. In another example, a third entity, such as a secondary lender, underwriter, insurer, or the like may be added to the EAL 3000, such as to facilitate multi-party transactions. In other embodiments, a multi-party, peer-to-peer EAL 3000 may handle transactions among a set of parties participating in a supply chain, such as tiers of component manufacturers that provide components of systems manufactured by an OEM. A peer-to-peer EAL 3000 may be established between a manufacturer or retailer with a set of preferred customers, such as repeat customers, such that the EAL allows the preferred customers access to view inventories (as presented in a wallet) in a manner that has priority over the access by the general public. The peer-to-peer EAL 3000 may include governing rules that are customized to each party (e.g., setting rules for what assets and transactions are presented or permitted), may provision and prioritize resources (e.g., for storage, processing, networking or the like) among parties, may allocate costs, and the like. The configured services of the EAL 3000 (of any of the types described herein), may include ones that are configured for the needs of each party, such as by learning on historical transactions of that party and/or on similarly situated other parties (such as ones from similar domains). In some embodiments, the peer-to-peer EAL 3000 may be a multi-tenant, peer-to-peer EAL 3000 having features described above.

Although the EAL 3000 has been generally described with respect to digital enterprise asset functionality, the EAL 3000 is not limited to digital assets, but may also perform its functionality for non-digital assets. For example, for a non-digital enterprise asset, the EAL 3000 may facilitate non-asset transactions by: managing transactional parties, permissions, logistics, or recordation of a transaction in some manner; providing intermediary services (e.g., escrow services for a physical transaction, authentication services, etc.); generating a digital means (e.g., a token or a transactional record) to indicate that a non-digital asset transaction has occurred; or processing/storing digital files related to a non-digital asset. As previously described, a physical resource, which may be considered a non-digital enterprise asset, may have associated documentation (e.g., certificate of authenticity, proof of purchase, deed, title, etc.). With associated documentation that can be generated, modified, transferred, processed, and/or stored in a digital context, the EAL 3000 can function to represent and/or manage some of all of these transactional instances.

In some implementations, the EAL 3000 may be configured to perform the transaction and/or to generate a record of the transaction for digital storage. For instance, the EAL 3000 generates a record of the transaction and stores the record on one or more blockchains (e.g., private blockchain associated with the enterprise and/or a public blockchain). In some configurations, similar to a digital asset transaction, when the EAL 3000 is integrated with the performance of a non-digital asset transaction, the capabilities of the EAL 3000 may generate records that store detailed information regarding a transaction. This detailed information may be information such as the enterprise's agent who authorized the transaction, any permissions required or satisfied to perform the transaction, any governance involved to perform the transaction, any decision-making intelligence requested/relied upon to perform the transaction, any data processing/data retrieval involved to perform the transaction, etc. In other words, the detailed information can log or record services performed by EAL systems or entities in cooperation with EAL systems.

### Intelligence Services System

FIG. 32 illustrates an example intelligence services system 3200 (also referred to as “intelligence services”) according to some embodiments of the present disclosure. In embodiments, the intelligence services 3200 provides a framework for providing intelligence services to one or more intelligence service clients 3236. In some embodiments, the intelligence services 3200 framework may be adapted to be at least partially replicated in respective intelligence clients 3236 (e.g., an enterprise access layer, a wallet system, a market orchestration system, a digital lending system, an asset-backed tokenization system, and/or the like). In these embodiments, an individual client 3236 may include some or all of the capabilities of the intelligence services 3200, whereby the intelligence services 3200 is adapted for the specific functions performed by the subsystems of the intelligence client. Additionally or alternatively, in some embodiments, the intelligence services 3200 may be implemented as a set of microservices, such that different intelligence clients 3236 may leverage the intelligence services 3200 via one or more APIs exposed to the intelligence clients. In these embodiments, the intelligence services 3200 may be configured to perform various types of intelligence services that may be adapted for different intelligence clients 3236. In either of these configurations, an intelligence service client 3236 may provide an intelligence request to the intelligence services 3200, whereby the request is to perform a specific intelligence task (e.g., a decision, a recommendation, a report, an instruction, a classification, a prediction, a training action, an NLP request, or the like). In response, the intelligence services 3200 executes the requested intelligence task and returns a response to the intelligence service client 3236. Additionally or alternatively, in some embodiments, the intelligence services 3200 may be implemented using one or more specialized chips that are configured to provide AI assisted microservices such as image processing, diagnostics, location and orientation, chemical analysis, data processing, and so forth. Examples of AI-enabled chips are discussed elsewhere in the disclosure.

In embodiments, an intelligence services 3200 may include an intelligence service controller 3202 and artificial intelligence (AI) modules 3204. In embodiments, an artificial intelligence services 3200 receives an intelligence request from an intelligence service client 3236 and any required data to process the request from the intelligence service client 3236. In response to the request and the specific data, one or more implicated artificial intelligence modules 3204 perform the intelligence task and output an “intelligence response”. Examples of intelligence modules 3204 responses may include a decision (e.g., a control instruction, a proposed action, machine-generated text, and/or the like), a prediction (e.g., a predicted meaning of a text snippet, a predicted outcome associated with a proposed action, a predicted fault condition, and/or the like), a classification (e.g., a classification of an object in an image, a classification of a spoken utterance, a classified fault condition based on sensor data, and/or the like), and/or other suitable outputs of an artificial intelligence system.

### Artificial Intelligence Modules

In embodiments, artificial intelligence modules 3204 may include an ML module 3212, a rules-based module 3228, an analytics module 3218, an RPA module 3216, a digital twin module 3220, a machine vision module 3222, an NLP module 3224, and/or a neural network module 3214. It is appreciated that the foregoing are non-limiting examples of artificial intelligence modules, and that some of the modules may be included or leveraged by other artificial intelligence modules. For example, the NLP module 3224 and the machine vision module 3222 may leverage different neural networks that are part of the neural network module 3214 in performance of their respective functions.

It is further noted that in some scenarios, artificial intelligence modules 3204 themselves may also be intelligence clients 3236. For example, a rules-based intelligence module 3228 may request an intelligence task from an ML module 3212 or a neural network F41 module 3214, such as requesting a classification of an object appearing in a video and/or a motion of the object. In this example, the rules-based intelligence module 3228 may be an intelligence service client 3236 that uses the classification to determine whether to take a specified action. In another example, a machine vision module 3222 may request a digital twin of a specified environment from a digital twin module 3220, such that the ML module 3212 may request specific data from the digital twin as features to train a machine-learned model that is trained for a specific environment.

In embodiments, an intelligence task may require specific types of data to respond to the request. For example, a machine vision task requires one or more images (and potentially other data) to classify objects appearing in an image or set of images, to determine features within the set of images (such as locations of items, presence of faces, symbols or instructions, expressions, parameters of motion, changes in status, and many others), and the like. In another example, an NLP task requires audio of speech and/or text data (and potentially other data) to determine a meaning or other element of the speech and/or text. In yet another example, an AI-based control task (e.g., a decision on movement of a robot) may require environment data (e.g., maps, coordinates of known obstacles, images, and/or the like) and/or a motion plan to make a decision as to how to control the motion of a robot. In a platform-level example, an analytics-based reporting task may require data from a number of different databases to generate a report. Thus, in embodiments, tasks that can be performed by an intelligence services 3200 may require, or benefit from, specific intelligence service inputs 3232. In some embodiments, an intelligence services 3200 may be configured to receive and/or request specific data from the intelligence service inputs 3232 to perform a respective intelligence task. Additionally or alternatively, the requesting intelligence service client 3236 may provide the specific data in the request. For instance, the intelligence services 3200 may expose one or more APIs to the intelligence clients 3236, whereby a requesting client 3236 provides the specific data in the request via the API. Examples of intelligence service inputs may include, but are not limited to, sensors that provide sensor data, video streams, audio streams, databases, data feeds, human input, and/or other suitable data.

In embodiments, intelligence modules 3204 includes and provides access to an ML module 3212 that may be integrated into or be accessed by one or more intelligence clients 3236. In embodiments, the ML module 3212 may provide machine-based learning capabilities, features, functions, and algorithms for use by an intelligence service client 3236 such as training ML models, leveraging ML models, reinforcing ML models, performing various clustering techniques, feature extraction, and/or the like. In an example, a machine learning module 3212 may provide machine learning computing, data storage, and feedback infrastructure to a simulation system (e.g., as described above). The machine learning module 3212 may also operate cooperatively with other modules, such as the rules-based module 3228, the machine vision module 3222, the RPA module 3216, and/or the like.

The machine learning module 3212 may define one or more machine learning models for performing analytics, simulation, decision making, and predictive analytics related to data processing, data analysis, simulation creation, and simulation analysis of one or more components or subsystems of an intelligence service client 3236. In embodiments, the machine learning models are algorithms and/or statistical models that perform specific tasks without using explicit instructions, relying instead on patterns and inference. The machine learning models build one or more mathematical models based on training data to make predictions and/or decisions without being explicitly programmed to perform the specific tasks. In example implementations, machine learning models may perform classification, prediction, regression, clustering, anomaly detection, recommendation generation, and/or other tasks.

In embodiments, the machine learning models may perform various types of classification based on the input data. Classification is a predictive modeling problem where a class label is predicted for a given example of input data. For example, machine learning models can perform binary classification, multi-class or multi-label classification. In embodiments, the machine-learning model may output “confidence scores” that are indicative of a respective confidence associated with classification of the input into the respective class. In embodiments, the confidence scores can be compared to one or more thresholds to render a discrete categorical prediction. In embodiments, only a certain number of classes (e.g., one) with the relatively largest confidence scores can be selected to render a discrete categorical prediction.

In embodiments, machine learning models may output a probabilistic classification. For example, machine learning models may predict, given a sample input, a probability distribution over a set of classes. Thus, rather than outputting only the most likely class to which the sample input should belong, machine learning models can output, for each class, a probability that the sample input belongs to such class. In embodiments, the probability distribution over all possible classes can sum to one. In embodiments, a Softmax function, or other type of function or layer can be used to turn a set of real values respectively associated with the possible classes to a set of real values in the range (0, 1) that sum to one. In embodiments, the probabilities provided by the probability distribution can be compared to one or more thresholds to render a discrete categorical prediction. In embodiments, only a certain number of classes (e.g., one) with the relatively largest predicted probability can be selected to render a discrete categorical prediction.

In embodiments, machine learning models can perform regression to provide output data in the form of a continuous numeric value. As examples, machine learning models can perform linear regression, polynomial regression, or nonlinear regression. As described, in embodiments, a Softmax function or other function or layer can be used to squash a set of real values respectively associated with two or more possible classes to a set of real values in the range (0, 1) that sum to one. For example, machine learning models can perform linear regression, polynomial regression, or nonlinear regression. As examples, machine learning models can perform simple regression or multiple regression. As described above, in some implementations, a Softmax function or other function or layer can be used to squash a set of real values respectively associated with two or more possible classes to a set of real values in the range (0, 1) that sum to one.

In embodiments, machine learning models may perform various types of clustering. For example, machine learning models may identify one or more previously-defined clusters to which the input data most likely corresponds. In some implementations in which machine learning models perform clustering, machine learning models can be trained using unsupervised learning techniques.

In embodiments, machine learning models may perform anomaly detection or outlier detection. For example, machine learning models can identify input data that does not conform to an expected pattern or other characteristic (e.g., as previously observed from previous input data). As examples, the anomaly detection can be used for fraud detection or system failure detection.

In some implementations, machine learning models can provide output data in the form of one or more recommendations. For example, machine learning models can be included in a recommendation system or engine. As an example, given input data that describes previous outcomes for certain entities (e.g., a score, ranking, or rating indicative of an amount of success or enjoyment), machine learning models can output a suggestion or recommendation of one or more additional entities that, based on the previous outcomes, are expected to have a desired outcome

As described above, machine learning models can be or include one or more of various different types of machine-learned models. Examples of such different types of machine-learned models are provided below for illustration. One or more of the example models described below can be used (e.g., combined) to provide the output data in response to the input data. Additional models beyond the example models provided below can be used as well.

In some implementations, machine learning models can be or include one or more classifier models such as, for example, linear classification models; quadratic classification models; etc. Machine learning models may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning models can be or include one or more decision tree-based models such as, for example, classification and/or regression trees; chi-squared automatic interaction detection decision trees; decision stumps; conditional decision trees; etc.

Machine learning models may be or include one or more kernel machines. In some implementations, machine learning models can be or include one or more support vector machines. Machine learning models may be or include one or more instance-based learning models such as, for example, learning vector quantization models; self-organizing map models; locally weighted learning models; etc. In some implementations, machine learning models can be or include one or more nearest neighbor models such as, for example, k-nearest neighbor classifications models; k-nearest neighbors regression models; etc. Machine learning models can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

Machine learning models may include one or more clustering models such as, for example, k-means clustering models; k-medians clustering models; expectation maximization models; hierarchical clustering models; etc.

In some implementations, machine learning models can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, machine learning models can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In embodiments, artificial intelligence modules 3204 may include and/or provide access to a neural network module 3214. In embodiments, the neural network module 3214 is configured to train, deploy, and/or leverage artificial neural networks (or “neural networks”) on behalf of an intelligence service client 3236. It is noted that in the description, the term machine learning model may include neural networks, and as such, the neural network module 3214 may be part of the machine learning module 3212. In embodiments, the neural network module 3214 may be configured to train neural networks that may be used by the intelligence clients 3236. Non-limiting examples of different types of neural networks may include any of the neural network types described throughout this disclosure and the documents incorporated herein by reference, including without limitation convolutional neural networks (CNN), deep convolutional neural networks (DCN), feed forward neural networks (including deep feed forward neural networks), recurrent neural networks (RNN) (including without limitation gated RNNs), long/short term memory (LTSM) neural networks, and the like, as well as hybrids or combinations of the above, such as deployed in series, in parallel, in acyclic (e.g., directed graph-based) flows, and/or in more complex flows that may include intermediate decision nodes, recursive loops, and the like, where a given type of neural network takes inputs from a data source or other neural network and provides outputs that are included within the input sets of another neural network until a flow is completed and a final output is provided. In embodiments, the neural network module 3214 may be leveraged by other artificial intelligence modules 3204, such as the machine vision module 3222, the NLP module 3224, the rules-based module 3228, the digital twin module 3226, and so on. Example applications of the neural network module 3214 are described throughout the disclosure.

A neural network includes a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

In embodiments, the neural networks can be or include one or more feed forward neural networks. In feed forward networks, the connections between nodes do not form a cycle. For example, each connection can connect a node from an earlier layer to a node from a later layer.

In embodiments, the neural networks can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of the input data sequence to a subsequent portion of the input data sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc. In some example embodiments, recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, neural networks can be or include one or more non-recurrent sequence-to-sequence models based on self-attention, such as Transformer networks. Details of an exemplary transformer network can be found at http://papers.nips.cc/paper/7181-attention-is-all-you-need.pdf.

In embodiments, the neural networks can be or include one or more convolutional neural networks. In some instances, a convolutional neural network can include one or more convolutional layers that perform convolutions over input data using learned filters. Filters can also be referred to as kernels. Convolutional neural networks can be especially useful for vision problems such as when the input data includes imagery such as still images or video. However, convolutional neural networks can also be applied for natural language processing.

In embodiments, the neural networks can be or include one or more generative networks such as, for example, generative adversarial networks. Generative networks can be used to generate new data such as new images or other content.

In embodiments, the neural networks may be or include autoencoders. In some instances, the aim of an autoencoder is to learn a representation (e.g., a lower-dimensional encoding) for a set of data, typically for the purpose of dimensionality reduction. For example, in some instances, an autoencoder can seek to encode the input data and then provide output data that reconstructs the input data from the encoding. Recently, the autoencoder concept has become more widely used for learning generative models of data. In some instances, the autoencoder can include additional losses beyond reconstructing the input data.

In embodiments, the neural networks may be or include one or more other forms of artificial neural networks such as, for example, deep Boltzmann machines; deep belief networks; stacked autoencoders; etc. Any of the neural networks described herein can be combined (e.g., stacked) to form more complex networks.

FIG. 33 illustrates an example neural network with multiple layers. Neural network 3240 may include an input layer, a hidden layer, and an output layer with each layer comprising a plurality of nodes or neurons that respond to different combinations of inputs from the previous layers. The connections between the neurons have numeric weights that determine how much relative effect an input has on the output value of the node in question. Input layer may include a plurality of input nodes 3242, 3244, 3246, 3248 and 3250 that may provide information from the outside world or input data (e.g., sensor data, image data, text data, audio data, etc.) to the neural network 3240. The input data may be from different sources and may include library data x1, simulation data x2, user input data x3, training data x4 and outcome data x5. The input nodes 3242, 3244, 3246, 3248 and 3250 may pass on the information to the next layer, and no computation may be performed by the input nodes. Hidden layers may include a plurality of nodes, such as nodes 3252, 3254, and 3256. The nodes in the hidden layer 3252, 3254, and 3256 may process the information from the input layer based on the weights of the connections between the input layer and the hidden layer and transfer information to the output layer. Output layer may include an output node 3258 which processes information based on the weights of the connections between the hidden layer and the output layer and is responsible for computing and transferring information from the network to the outside world, such as recognizing certain objects or activities, or predicting a condition or an action.

In embodiments, a neural network 3240 may include two or more hidden layers and may be referred to as a deep neural network. The layers are constructed so that the first layer detects a set of primitive patterns in the input (e.g., image) data, the second layer detects patterns of patterns and the third layer detects patterns of those patterns. In some embodiments, a node in the neural network 3240 may have connections to all nodes in the immediately preceding layer and the immediate next layer. Thus, the layers may be referred to as fully-connected layers. In some embodiments, a node in the neural network 3240 may have connections to only some of the nodes in the immediately preceding layer and the immediate next layer. Thus, the layers may be referred to as sparsely-connected layers. Each neuron in the neural network consists of a weighted linear combination of its inputs and the computation on each neural network layer may be described as a multiplication of an input matrix and a weight matrix. A bias matrix is then added to the resulting product matrix to account for the threshold of each neuron in the next level. Further, an activation function is applied to each resultant value, and the resulting values are placed in the matrix for the next layer. Thus, the output from a node i in the neural network may be represented as:

$$y i = f ( \sum x i w i + b i )$$

where f is the activation function, Σxiwi is the weighted sum of input matrix and bi is the bias matrix.

The activation function determines the activity level or excitation level generated in the node as a result of an input signal of a particular size. The purpose of the activation function is to introduce non-linearity into the output of a neural network node because most real-world functions are non-linear and it is desirable that the neurons can learn these non-linear representations. Several activation functions may be used in an artificial neural network. One example activation function is the sigmoid function σ(x), which is a continuous S-shaped monotonically increasing function that asymptotically approaches fixed values as the input approaches plus or minus infinity. The sigmoid function σ(x) takes a real-valued input and transforms it into a value between 0 and 1:

$$o ( x ) = 1 / ( 1 + exp ( - x ) ) .$$

Another example activation function is the tanh function, which takes a real-valued input and transforms it into a value within the range of [−1, 1]:

$$tanh ( x ) = 2 σ ( 2 x ) - 1$$

A third example activation function is the rectified linear unit (ReLU) function. The ReLU function takes a real-valued input and thresholds it above zero (i.e., replacing negative values with zero):

f(x)=max(0,x).

It will be apparent that the above activation functions are provided as examples and in various embodiments, neural network 3240 may utilize a variety of activation functions including (but not limited to) identity, binary step, logistic, soft step, tan h, arctan, softsign, rectified linear unit (ReLU), leaky rectified linear unit, parameteric rectified linear unit, randomized leaky rectified linear unit, exponential linear unit, s-shaped rectified linear activation unit, adaptive piecewise linear, softplus, bent identity, softexponential, sinusoid, sinc, gaussian, softmax, maxout, and/or a combination of activation functions.

In the example shown in FIG. 33, nodes 3242, 3244, 3246, 3248 and 3250 in the input layer may take external inputs x1, x2, x3, x4 and x5 which may be numerical values depending upon the input dataset. It will be understood that even though only five inputs are shown in FIG. 33, in various implementations, a node may include tens, hundreds, thousands, or more inputs. As discussed above, no computation is performed on the input layer and thus the outputs from nodes 3242, 3244, 3246, 3248 and 3250 of input layer are x1, x2, x3, x4 and x5 respectively, which are fed into hidden layer. The output of node 3252 in the hidden layer may depend on the outputs from the input layer (x1, x2, x3, x4 and x5) and weights associated with connections (w1, w2, w3, w4 and w5). Thus, the output from node 3252 may be computed as:

$${Y}_{23552} = f ( x 1 w 1 + x 2 w 2 + x 3 w 3 + x 4 w 4 + x 5 w 5 + {b}_{23552} ) .$$

The outputs from the nodes 3254 and 3256 in the hidden layer may also be computed in a similar manner and then be fed to the node 3258 in the output layer. Node 3258 in the output layer may perform similar computations (using weights v1, v2 and v3 associated with the connections) as the nodes 3252, 3254 and 3256 in the hidden layers:

$${Y}_{23558} = f ( {y}_{23552} v 1 + {y}_{23554} v 2 + {y}_{23556} v 3 + {b}_{23558} ) ;$$

where Y₂₃₅₄₀ is the output of the neural network 3240.

As mentioned, the connections between nodes in the neural network have associated weights, which determine how much relative effect an input value has on the output value of the node in question. Before the network is trained, random values are selected for each of the weights. The weights are adjusted during the training process and this adjustment of weights to determine the best set of weights that maximize the accuracy of the neural network is referred to as training. For every input in a training dataset, the output of the artificial neural network may be observed and compared with the expected output, and the error between the expected output and the observed output may be propagated back to the previous layer. The weights may be adjusted accordingly based on the error. This process is repeated until the output error is below a predetermined threshold.

In embodiments, backpropagation (e.g., backward propagation of errors) is utilized with an optimization method such as gradient descent to adjust weights and update the neural network characteristics. Backpropagation may be a supervised training scheme that learns from labeled training data and errors at the nodes by changing parameters of the neural network to reduce the errors. For example, a result of forward propagation (e.g., output activation value(s)) determined using training input data is compared against a corresponding known reference output data to calculate a loss function gradient. The gradient may be then utilized in an optimization method to determine new updated weights in an attempt to minimize a loss function. For example, to measure error, the mean square error is determined using the equation:

$$E = ( target - output ) 2$$

To determine the gradient for a weight “w,” a partial derivative of the error with respect to the weight may be determined, where:

$$gradient = \partial E / \partial w$$

The calculation of the partial derivative of the errors with respect to the weights may flow backwards through the node levels of the neural network. Then a portion (e.g., ratio, percentage, etc.) of the gradient is subtracted from the weight to determine the updated weight. The portion may be specified as a learning rate “a.” Thus an example equation of determining the updated weight is given by the formula:

$$w new = w old - α \partial E / \partial w$$

The learning rate must be selected such that it is not too small (e.g., a rate that is too small may lead to a slow convergence to the desired weights) and not too large (e.g., a rate that is too large may cause the weights to not converge to the desired weights).

After the weight adjustment, the network should perform better than before for the same input because the weights have now been adjusted to minimize the errors.

As mentioned, neural networks may include convolutional neural networks (CNN). A CNN is a specialized neural network for processing data having a known, grid-like topology, such as image data. Accordingly, CNNs are commonly used for classification, object recognition and computer vision applications, but they also may be used for other types of pattern recognition such as speech and language processing.

A convolutional neural network learns highly non-linear mappings by interconnecting layers of artificial neurons arranged in many different layers with activation functions that make the layers dependent. It includes one or more convolutional layers, interspersed with one or more sub-sampling layers and non-linear layers, which are typically followed by one or more fully connected layers.

Referring to FIG. 34, a CNN 3260 includes an input layer with an input image 3262 to be classified by the CNN 3260, a hidden layer which in turn includes one or more convolutional layers, interspersed with one or more activation or non-linear layers (e.g., ReLU) and pooling or sub-sampling layers and an output layer-typically including one or more fully connected layers. Input image 3262 may be represented by a matrix of pixels and may have multiple channels. For example, a colored image may have a red, a green, and blue channels each representing red, green, and blue (RGB) components of the input image. Each channel may be represented by a 2-D matrix of pixels having pixel values in the range of 0 to 255. A gray-scale image on the other hand may have only one channel. The following section describes processing of a single image channel using CNN 3260. It will be understood that multiple channels may be processed in a similar manner.

As shown, input image 3262 may be processed by the hidden layer, which includes sets of convolutional and activation layers 3264 and 3268, each followed by pooling layers 3266 and 3270.

The convolutional layers of the convolutional neural network serve as feature extractors capable of learning and decomposing the input image into hierarchical features. The convolution layers may perform convolution operations on the input image where a filter (also referred as a kernel or feature detector) may slide over the input image at a certain step size (referred to as the stride). For every position (or step), element-wise multiplications between the filter matrix and the overlapped matrix in the input image may be calculated and summed to get a final value that represents a single element of an output matrix constituting a feature map. The feature map refers to image data that represents various features of the input image data and may have smaller dimensions as compared to the input image. The activation or non-linear layers use different non-linear trigger functions to signal distinct identification of likely features on each hidden layer. Non-linear layers use a variety of specific functions to implement the non-linear triggering, including the rectified linear units (ReLUs), hyperbolic tangent, absolute of hyperbolic tangent and sigmoid functions. In one implementation, a ReLU activation implements the function y=max(x, 0) and keeps the input and output sizes of a layer the same. The advantage of using ReLU is that the convolutional neural network is trained many times faster. ReLU is a non-continuous, non-saturating activation function that is linear with respect to the input if the input values are larger than zero and zero otherwise.

As shown in FIG. 34, the first convolution and activation layer 3264 may perform convolutions on input image 3262 using multiple filters followed by non-linearity operation (e.g., ReLU) to generate multiple output matrices (or feature maps) 3272. The number of filters used may be referred to as the depth of the convolution layer. Thus, the first convolution and activation layer 3264 in the example of FIG. 34 has a depth of three and generates three feature maps using three filters. Feature maps 3272 may then be passed to the first pooling layer that may sub-sample or down-sample the feature maps using a pooling function to generate output matrix 3274. The pooling function replaces the feature map with a summary statistic to reduce the spatial dimensions of the extracted feature map thereby reducing the number of parameters and computations in the network. Thus, the pooling layer reduces the dimensionality of the feature maps while retaining the most important information. The pooling function can also be used to introduce translation invariance into the neural network, such that small translations to the input do not change the pooled outputs. Different pooling functions may be used in the pooling layer, including max pooling, average pooling, and 12-norm pooling.

Output matrix 3274 may then be processed by a second convolution and activation layer 3268 to perform convolutions and non-linear activation operations (e.g., ReLU) as described above to generate feature maps 3276. In the example shown in FIG. 34, second convolution and activation layer 3268 may have a depth of five. Feature maps 3276 may then be passed to a pooling layer 3270, where feature maps 3276 may be subsampled or down-sampled to generate an output matrix 3278.

Output matrix 3278 generated by pooling layer 3270 is then processed by one or more fully connected layer 3280 that forms a part of the output layer of CNN 3260. The fully connected layer 3280 has a full connection with all the feature maps of the output matrix 3278 of the pooling layer 3270. In embodiments, the fully connected layer 3280 may take the output matrix 3278 generated by the pooling layer 3270 as the input in vector form, and perform high-level determination to output a feature vector containing information of the structures in the input image. In embodiments, the fully-connected layer 3280 may classify the object in input image 3262 into one of several categories using a Softmax function. The Softmax function may be used as the activation function in the output layer and takes a vector of real-valued scores and maps it to a vector of values between zero and one that sum to one. In embodiments, other classifiers, such as a support vector machine (SVM) classifier, may be used.

In embodiments, one or more normalization layers may be added to the CNN 3260 to normalize the output of the convolution filters. The normalization layer may provide whitening or lateral inhibition, avoid vanishing or exploding gradients, stabilize training, and enable learning with higher rates and faster convergence. In embodiments, the normalization layers are added after the convolution layer but before the activation layer.

CNN 3260 may thus be seen as multiple sets of convolution, activation, pooling, normalization and fully connected layers stacked together to learn, enhance and extract implicit features and patterns in the input image 3262. A layer as used herein, can refer to one or more components that operate with similar function by mathematical or other functional means to process received inputs to generate/derive outputs for a next layer with one or more other components for further processing within CNN 3260.

The initial layers of CNN 3260 e.g., convolution layers, may extract low level features such as edges and/or gradients from the input image 3262. Subsequent layers may extract or detect progressively more complex features and patterns such as presence of curvatures and textures in image data and so on. The output of each layer may serve as an input of a succeeding layer in CNN 3260 to learn hierarchical feature representations from data in the input image 3262. This allows convolutional neural networks to efficiently learn increasingly complex and abstract visual concepts.

Although only two convolution layers are shown in the example, the present disclosure is not limited to the example architecture, and CNN 3260 architecture may comprise any number of layers in total, and any number of layers for convolution, activation and pooling. For example, there have been many variations and improvements over the basic CNN model described above. Some examples include Alexnet, GoogLeNet, VGGNet (that stacks many layers containing narrow convolutional layers followed by max pooling layers), Residual network or ResNet (that uses residual blocks and skip connections to learn residual mapping), DenseNet (that connects each layer of CNN to every other layer in a feed-forward fashion), Squeeze and excitation networks (that incorporate global context into features) and AmobeaNet (that uses evolutionary algorithms to search and find optimal architecture for image recognition).

### Training of Convolutional Neural Network

The training process of a convolutional neural network, such as CNN 3260, may be similar to the training process discussed in FIG. 33 with respect to neural network 3240.

In embodiments, all parameters and weights (including the weights in the filters and weights for the fully-connected layer are initially assigned (e.g., randomly assigned). Then, during training, a training image or images, in which the objects have been detected and classified, are provided as the input to the CNN 3260, which performs the forward propagation steps. In other words, CNN 3260 applies convolution, non-linear activation, and pooling layers to each training image to determine the classification vectors (i.e., detect and classify each training image). These classification vectors are compared with the predetermined classification vectors. The error (e.g., the squared sum of differences, log loss, softmax log loss) between the classification vectors of the CNN and the predetermined classification vectors is determined. This error is then employed to update the weights and parameters of the CNN in a backpropagation process which may use gradient descent and may include one or more iterations. The training process is repeated for each training image in the training set.

The training process and inference process described above may be performed on hardware, software, or a combination of hardware and software. However, training a convolutional neural network like CNN 3260 or using the trained CNN for inference generally requires significant amounts of computation power to perform, for example, the matrix multiplications or convolutions. Thus, specialized hardware circuits, such as graphic processing units (GPUs), tensor processing units (TPUs), neural network processing units (NPUs), FPGAs, ASICs, or other highly parallel processing circuits may be used for training and/or inference. Training and inference may be performed on a cloud, on a data center, or on a device.

### Region Based CNNs (RCNNs) and Object Detection

In embodiments, an object detection model extends the functionality of CNN based image classification neural network models by not only classifying objects but also determining their locations in an image in terms of bounding boxes. Region-based CNN (R-CNN) methods are used to extract regions of interest (ROI), where each ROI is a rectangle that may represent the boundary of an object in image. Conceptually, R-CNN operates in two phases. In a first phase, region proposal methods generate all potential bounding box candidates in the image. In a second phase, for every proposal, a CNN classifier is applied to distinguish between objects. Alternatively, a fast R-CNN architecture can be used, which integrates the feature extractor and classifier into a unified network. Another faster R-CNN can be used, which incorporates a Region Proposal Network (RPN) and fast R-CNN into an end-to-end trainable framework. Mask R-CNN adds instance segmentation, while mesh R-CNN adds the ability to generate a 3D mesh from a 2D image.

Referring back to FIG. 32, in embodiments, the artificial intelligence modules 3204 may provide access to and/or integrate a robotic process automation (RPA) module 3216. The RPA module 3216 may facilitate, among other things, computer automation of producing and validating workflows. The RPA module 3216 provides automation of tasks performed by humans, such as receiving and reviewing written information, entering data into user interfaces, converting or otherwise processing data such as files or records, recording observations, generating documents such as reports, and communicating with other users by mechanisms such as email. In some cases, the tasks involve a workflow that includes a number of interrelated steps, contextual information that relates to the task, and interactions with other applications and humans. The RPA module 3216 can be configured to receive or learn one or more such workflows on behalf of the human and in a manner similar to the actions and logic of the human, and can thereafter perform such workflows in response to various triggers such as events. Examples of RPA modules 3216 may encompass those in this disclosure and in the documents incorporated by reference herein and may involve automation of any of the wide range of activities or entities described therein.

In embodiments, an RPA module 3216 is configured to receive or learn a robotic process automation workflow in a variety of ways. As a first example, in embodiments, the RPA module 3216 can include a graphical user interface (GUI) that enables a user to specify the details of the robotic process automation workflow. The GUI can include components that represent different types of actions, such as an action of receiving input from a user or application, an action of converting or otherwise processing data, and an action of providing input to an application. The GUI can receive, from the user, a selection of components representing actions that correspond to the steps of the workflow when performed by a human. The GUI can also receive, from the user, an interconnection of the selected components, such as a logical order in which the corresponding actions are to be performed, or a dependency of one component upon another component (e.g., a first component can output data that is received as input by another component). The GUI can include one or more templates, such as one or more sequences of actions that are performed together to complete a common workflow. The GUI can receive, from the user, a selection of a template, optionally including one or more details that adapt the selected template to a particular workflow performed by the human. Based on the input received from the user, the RPA module 3216 can generate a robotic process automation workflow that can be executed to perform the workflow. The RPA module 3216 can store the generated workflow for future use. For example, the RPA module 3216 can execute the compiled code or interpret the generated script to perform the workflow in a similar manner as performed by the human.

As a second example, in embodiments, an RPA module 3216 is configured to receive or learn a workflow based on a set of rules. For example, the RPA module 3216 can include a GUI that enables a user to specify the details of the robotic process automation workflow as a set of conditions and responsive actions. The GUI includes a set of components that respond to conditions to be monitored, such as a status of a resource or an occurrence of an event. The GUI for designing the workflows can include a set of components that represent actions to be taken in response to an occurrence of one of the conditions. The GUI can receive, from the user, a selection of components representing one or more of the conditions of a workflow, and a selection of one or more components representing the actions to be taken in response to the conditions. In some embodiments, the GUI can include one or more templates, such as one or more conditions associated with one or more actions that correspond to a common workflow. The GUI can receive, from the user, a selection of one of the templates, including one or more details that adapt the selected template to a particular workflow performed by the human. Based on the input received from the user, the RPA module 3216 can generate a robotic process automation workflow that automates a set of tasks in response to one or more detected events. The RPA module 3216 can store the generated workflow for future use. For example, the RPA module 3216 can monitor the selected conditions and perform the selected actions in response to an occurrence of the selected actions, in a similar manner as performed by the human.

As a third example, in embodiments, an RPA module 3216 is configured to learn a workflow by recording a set of actions performed by a human to complete the workflow. For example, the RPA module 3216 can receive, from the user, an indication of a start of the workflow involving a device, such as a selection of a Start Recording button. The RPA module 3216 can receive user input from the user, such as input to one or more human interaction devices (HIDs) such as a keyboard, a mouse, a touchscreen, a camera, or a microphone. Alternatively or additionally, the RPA module 3216 can receive user input as a series of human interaction events reported by a device, such as an input layer of an operating system that receives and aggregates user input from one or more human input devices. Alternatively or additionally, the RPA module 3216 can receive user input as a series of events reported by one or more applications, such as a web browser that reports a set of user input events. The RPA module 3216 can record the user input as a sequence of inputs. The RPA module 3216 can associate the recorded user input with contextual information, such as an identification of the application to which the user input was directed. The RPA module 3216 can associate the recorded user input with other events, such as preceding events of an application that receives the user input (e.g., an indication by a web browser that a web page has been rendered and is available to receive user input) and/or responsive events of the application in response to receiving the user input (e.g., an action performed by a web page in response to receiving user input). The RPA module 3216 can associate the recorded user input with other events occurring within the device, such as an action performed by another application or an operating system of the device in response to the user input. The RPA module 3216 can receive, from the user, an indication of an end of the workflow, such as a selection of a Stop Recording button. The RPA module 3216 can generate a workflow that includes a record of the observed user input, optionally in association with other data. The RPA module 3216 can store the generated workflow for future use. For example, the RPA module 3216 can replay the sequence of recorded user input to perform the workflow in a similar manner as performed by the human.

As a fourth example, in embodiments, an RPA module 3216 is configured to learn a workflow by watching an interaction between a human and a device. For example, a human can perform a number of workflows using the device over a period of time, such as a business day. The RPA module 3216 can monitor the user input of the human and can identify, in the user input, one or more patterns of actions that are repeatedly performed by the human. The RPA module 3216 can determine that a pattern of actions corresponds to a workflow performed by the human. In some embodiments, the RPA module 3216 can identify variations among various instances of the actions when performed by the human during the workflow, such as different types of data entry that occur in different instances of the actions. The RPA module 3216 can associate an action in the workflow with one or more parameters, wherein the parameters correspond to the different variations among the various instances of the action when performed by the human. In various embodiments, the RPA module 3216 can determine a basis of each of the variations of the action that are associated with different variations of the action in the workflow. For example, the RPA module 3216 can determine that when the workflow is performed by the human on behalf of a first user, the action is to be performed with a first data entry value, such as data entry including the name of the first user. When the workflow is performed by the human on behalf of a second user, the action is to be performed with a second data entry value, such as data entry including the name of the second user. The data entry can be represented in the workflow as a data entry parameter (e.g., a name of a user on whose behalf the workflow is performed), optionally with specific values that correspond to a context of the workflow (e.g., the names of the users on whose behalf the workflow can be performed). The RPA module 3216 can generate a workflow that includes a sequence of commands that correspond to the pattern of actions performed by the user during the workflow, and, optionally, the parameters and/or parameter values of various actions of the workflow. The RPA module 3216 can store the generated workflow for future use. For example, the RPA module 3216 can replay the sequence of commands to replicate the pattern of actions that correspond to the workflow when performed in a similar manner as by the human.

In embodiments, the RPA module 3216 can be implemented in a variety of architectures. As a first example, the RPA module 3216 can be implemented on the same device as a human uses to perform a workflow, and/or that a user uses to specify the details of a workflow. The RPA module 3216 can store one or more generated workflows on the device, and can perform the workflow on the same device. As a second example, the RPA module 3216 can be implemented on a first device to replicate a workflow performed by a human on a second device. The RPA module 3216 can monitor the interaction of the human with the second device while performing a task, generate and store a workflow on the first device, and execute the workflow on the first device to perform the task on the first device in a similar manner as performed by the user on the second device. As a third example, the RPA module 3216 can be implemented on a first device to generate a workflow that corresponds to a task performed by the human on the first device, and can transmit the workflow to a second device. The workflow can cause the second device to perform the task on the second device in a similar manner as performed by the user on the first device. As a fourth example, the RPA module 3216 can be implemented on a second device to receive a workflow that corresponds to a task performed by the human on a first device. The RPA module 3216 workflow can execute the workflow on the second device to perform the task on the second device in a similar manner as performed by the user on the first device. In some embodiments, the RPA module 3216 can be distributed over a set of two or more devices, such as a first portion of the RPA module 3216 that executes on a first device to generate a workflow based on an interaction between a human and the first device, and a second portion of the RPA module 3216 that executes on a second device to perform the workflow on the second device. In some embodiments, at least a portion of the RPA module 3216 can be replicated over a plurality of devices, such as two or more devices that each perform (e.g., concurrently and/or consecutively) a workflow that was generated based on an interaction between a human and a first device. In some embodiments, different RPA modules 3216 executing on each of a plurality of devices can interact to execute one or more workflows (e.g., a first RPA module 3216 that executes on a first device to perform a first portion of a workflow, and a second RPA module 3216 that executes on a second device to perform a second portion of the same workflow). Each RPA module 3216 can operate in a particular role while performing at least a portion of a workflow, such as a first RPA module 3216 that executes on a cloud edge device to receive an input of a workflow, a second RPA module 3216 that executes on a cloud server to process the input of the workflow, and a third RPA module 3216 that executes on another cloud edge device to present an output of the workflow.

In embodiments, an RPA module 3216 can perform a workflow in response to a variety of triggers. The RPA module 3216 can perform a workflow in response to a request of a user, such as a request to execute code or run a particular script in order to perform a learned workflow. The RPA module 3216 can perform a workflow in response to a detection of a pattern of activity by a human (e.g., a second workflow that is to be performed by the RPA module 3216 in response to a completion of a first workflow by a human). The RPA module 3216 can perform at least a portion of a workflow in lieu of a human performing at least a portion of the workflow. For example, the RPA module 3216 can detect a start of a workflow by a human, and can suggest to the human that the RPA module 3216 perform the rest of the workflow. Upon receiving an acceptance of the suggestion, the RPA module 3216 can perform the entire workflow in lieu of the human, and/or one or more remaining steps of the workflow following the initial steps performed by the human. The RPA module 3216 can perform a workflow in response to an occurrence of a type of data (e.g., the device receiving a file that includes particular data type, such as a particular type of document or a particular type of image). The RPA module 3216 can perform a workflow in response to receiving a message through a communication channel such as email, telephone, text message, gesture input received by a camera or haptic input device, or voice input received by a microphone. The RPA module 3216 can perform a workflow in response to receiving a request from an operating system or an application executing on the device (e.g., a request from a spreadsheet application in response to a user entering a certain type of data). The RPA module 3216 can perform a workflow in response to a detected event. For example, when a device recognizes a presence of a particular human (e.g., when a camera of a device recognizes a face of the human), the RPA module 3216 can perform a workflow that involves displaying a report for the human. The RPA module 3216 can perform a workflow at a scheduled interval, such as once per hour or once per day. The RPA module 3216 can perform a workflow in response to a request received from another workflow executed on the same device or another device (e.g., a second workflow that is to be performed upon completion of a first workflow).

In embodiments, an RPA module 3216 can perform a workflow based on a variety of inputs. The RPA module 3216 can perform a workflow based on one or more details of a trigger of the workflow. For example, if the workflow is being performed in response to a request of a user to perform the workflow, the RPA module 3216 can perform the workflow based on one or more details of the request. For example, if the workflow was triggered by a request of a user to process a particular document, the RPA module 3216 can perform the workflow based on one or more details of the document. If the workflow is being performed in response to a message or telephone call, the RPA module 3216 can perform the workflow based on an identity of the sender of the message or the identity of the caller. If the workflow is being performed as a daily instance based on a schedule, the RPA module 3216 can perform the workflow based on the day of the week on which the workflow is being performed. If a workflow is being performed in response to a detection of a condition, the RPA module 3216 can perform the workflow based on one or more details of the condition. For example, if the condition is a storage capacity of a device that exceeds a storage capacity threshold, the RPA module 3216 can perform the workflow based on a severity of the storage capacity condition (e.g., a remaining storage capacity of the device). The RPA module 3216 can perform a workflow based on a data source, such as one or more files of a file system, one or more rows or records of a database, or one or more messages received by a network interface. If the RPA module 3216 is performing a workflow in response to one or more events, the RPA Module 3216 can perform the workflow based on one or more details of the event. For example, if the RPA module 3216 is performing a second workflow in response to a completion of a first workflow on the same device or another device, the RPA module 3216 can perform the workflow based on a date or time of the completion of the first workflow, a result of the first workflow, and/or an output of the first workflow. The RPA module 3216 can perform a workflow based on one or more contextual details. For example, the RPA module 3216 can perform a workflow based on a detected number and identities of humans who are present in the proximity of a device. The RPA module 3216 can perform a workflow based on data associated with an application executing on the device. For example, if the RPA module 3216 performs the workflow based on a loading of a web page, the RPA module 3216 can perform the workflow based on data scraped from the contents of the web page. The RPA module 3216 can perform the workflow based on observation of human actions that involve interactions with hardware elements, with software interfaces, and with other elements. Observations may include field observations as humans perform real tasks, as well as observations of simulations or other activities in which a human performs an action with the explicit intent to provide a training data set or input for the RPA module 3216, such as where a human tags or labels a training data set with features that assist the RPA module 3216 in learning to recognize or classify features or objects, among many other examples.

In embodiments, an RPA module 3216 can interact with one or more applications while performing the workflow. For example, the RPA module 3216 can extract data from a variable or an object of an application, such as text content of a textbox in a web form or the contents of cells in a spreadsheet. The RPA module 3216 can extract data stored within an application (e.g., by inspecting a memory space of the application). The RPA module 3216 can analyze data generated as output by the application (e.g., one or more files generated by the application, one or more rows or records of a spreadsheet generated by the application, or one or more network communication messages received and/or transmitted by the application over a network). The RPA module 3216 can invoke an application programming interface (API) of the application to request data from the application, and can receive and analyze data provided by the application in response to the invocation of the API. The RPA module 3216 can examine one or more properties of the device on which the application is executing (e.g., a portion of a display of the devices that includes a graphical user interface of the application) to extract data from the application. Alternatively or additionally, the RPA module 3216 can provide data to an application and/or modify a behavior of an application while performing the workflow. For example, the RPA module 3216 can generate user input that is directed to an application (e.g., simulating a human interaction device (HID), such as a keyboard, to generate keystrokes that are delivered to the application as user input). The RPA module 3216 can directly transmit and/or modify data of the application (e.g., altering HTML data stored in a rendered web page to modifying the contents of the textbox, or directly modifying data in the memory space of an application). The RPA module 3216 can request the operating system to interact with and/or modify the behavior of an application (e.g., requesting that the device start, activate, suspend, resume, close, or terminate an application). The RPA module 3216 can invoke an API of the application to provide data to the application (e.g., invoking an API of a spreadsheet to request the entry of data into a particular cell). The RPA module 3216 can invoke code associated with an application to provide data and/or modify the behavior of the application (e.g., executing code that is encoded in an application-specific programming language and embedded in a document used by an application or invoking a stored procedure of a database associated with the application). The RPA module 3216 can cause or allow an interaction with an application to be visible to a human (e.g., the RPA module 3216 can provide user input that simulates a user visually activating a spreadsheet application and visually typing data into various cells of the spreadsheet application). The RPA module 3216 can hide an interaction with an application from a human (e.g., visually hiding a window of an application while entering data into one or more textboxes of the window of the application).

In embodiments, an RPA module 3216 can utilize a variety of logical processes while performing a workflow. The RPA module 3216 can retrieve, interpret, analyze, convert, validate, aggregate, partition, render, store, and/or otherwise process data that was received and/or is associated with the workflow. The RPA module 3216 can transmit the data to another workflow, application, or device for processing or storage, and/or can query or receive the data from another workflow, application, or device. The RPA module 3216 can apply an optical character recognition (OCR) process to an image (e.g., a picture of a form or a document) to determine and extract text content from the image. The RPA module 3216 can apply a computer vision process to an image (e.g., a photograph captured by a camera) to determine and extract image data from the image, such as detecting, recognizing, classifying, and/or localizing one or more objects. The RPA module 3216 can apply a speech recognition process to a sound input (e.g., a voice input from a telephone call or a microphone) to determine and extract voice content from the image, such as one or more voice commands. The RPA module 3216 can apply a gesture recognition process to an input device (e.g., a camera, proximity sensor, or inertial measurement unit that detects movement of a hand) to determine one or more gestures performed by a human. The RPA module 3216 can apply a pattern recognition process to data to detect one or more patterns in the data (e.g., analyzing sensor data from a machine to detect one or more occurrences of an event associated with the machine, such as a movement of a moving part of the machine).

In embodiments, the RPA module 3216 performs a workflow in cooperation with a human or another workflow. For example, a workflow can include one or more human portions to be performed by a human and one or more automated portions to be performed by the RPA module 3216. The RPA module 3216 can first perform an automated portion and deliver a result of the automated portion to the human so that the human can perform a human portion based on the result. The RPA module 3216 can receive a result of a human portion of the workflow and can perform an automated portion of the workflow on the result of the human portion of the workflow. The RPA module 3216 can perform the automated portion of the workflow concurrently with a human performing a human portion of the workflow, and can then combine a result of the automated portion of the workflow with a result of the human portion of the workflow. The RPA module 3216 can perform a first automated portion of the workflow, present a result of the first automated portion to a human for review and validation, and can perform a second automated portion of the workflow based on the review and validation of the result of the first automated portion based on a result of the review and validation by the human.

In embodiments, an RPA module 3216 may learn to perform certain tasks based on the learned patterns and processes. The RPA module 3216 can use one or more artificial intelligence modules 3204 to perform one or more steps of a workflow. For example, an RPA module 3216 can perform a data classification step on input data by applying a classification neural network to the input data. An RPA module 3216 can perform a pattern recognition step on input data by applying a pattern recognition neural network to the input data. An RPA module 3216 can perform a computer vision processing step and/or an optical character recognition step of a workflow by applying one or CNNs 3260 to an image. An RPA module 3216 can perform a sequential analysis step involving time series data by applying one or more recurrent neural networks (RNNs) to the time series data. An RPA module 3216 can perform one or more natural language processing steps on a natural-language expression (e.g., a natural-language document or a natural-language voice input) by applying one or more transformer-based neural networks to the natural-language expression.

In various embodiments, the RPA module 3216 uses one or more artificial intelligence modules 3204 that are untrained. For example, the one or more artificial intelligence modules 3204 can include a k-nearest-neighbor model that determines a classification of a received input based on a proximity of the received input to a collection of other inputs with known classifications. The k-nearest-neighbor model then classifies the received input according to a majority of the known classifications of the determined k inputs that are closest to the received input.

In various embodiments, the RPA module 3216 uses one or more artificial intelligence modules 3204 that are trained in an unsupervised manner. For example, the workflow can include an anomaly detection step, such as determining a portion of a form that includes handwritten text. An anomaly detection algorithm can partition the form into a collection of symbols, and can compare the symbols to distinguish between symbols that occur with a high frequency (e.g., machine-printed characters in a font) from symbols that occur with a low frequency (e.g., hand-printed characters that are unique or at least highly variable). The anomaly detection algorithm can therefore partition the form into regions that include machine-printed characters and regions that include hand-printed characters. The RPA module 3216 can then process each region of the document with either an OCR module that is configured to recognize machine-printed characters in a font or an OCR module that is configured to recognize hand-printed characters.

In various embodiments, the RPA module 3216 uses one or more artificial intelligence modules 3204 that are specifically designed and/or trained for the workflow. For example, the workflow can be associated with a training data set, and the RPA module 3216 can train one or more machine learning models to perform the processing of the workflow based on the training data set. In various embodiments, the RPA module 3216 uses one or more pretrained artificial intelligence modules 3204 to perform the processing of the workflow. For example, the RPA module 3216 can receive a partially pretrained natural language processing (NLP) machine learning model that is generally trained to recognize sentence structure and word meaning. The RPA module 3216 can adapt the partially pretrained NLP machine learning model based on natural-language expressions that are more specifically associated with the workflow. The adaptation can involve applying transfer learning to an artificial intelligence module 3204 (e.g., more specifically training one or more classification layers in a classification portion of the NLP machine learning model while holding other portions of the NLP machine learning model constant). The adaptation can involve retraining an artificial intelligence module 3204 (e.g., retraining an entirety of an NLP machine learning model based on natural-language expressions that are associated with a workflow). The adaptation can involve generating an ensemble of artificial intelligence modules 3204 to perform the workflow (e.g., two or more artificial intelligence modules 3204, each of which performs classification of data in a different way, wherein an output classification of the workflow is based on a consensus of the two or more artificial intelligence modules 3204). The artificial intelligence modules 3204 can include a random forest, in which each of one or more decision trees analyses an input data according to different criteria, and an output of the random forest is based on a consensus of the decision trees. The artificial intelligence modules 3204 can include a stacking ensemble, in which each of two or more machine learning models processes data to generate an output, and another machine learning model determines which output, among the outputs of the two or more machine learning models, is to be used as the output of processing the data.

In embodiments, the RPA module 3216 generates one or more outputs or results of a workflow. The RPA module 3216 can generate, as output, data that can be stored by the device (e.g., as a file in a file system or as a row or record in a database). The RPA module 3216 can generate, as output, data that is included in another data set (e.g., text entered into fields of a form, numbers entered into cells of a spreadsheet, or text entered into textboxes of a web page). The RPA module 3216 can generate, as output, data that is transmitted to another device (e.g., a submission of form data of a web page to a webserver). The RPA module 3216 can generate, as output, data that is communicated to one or more users (e.g., a visual notification of a result displayed for a user of the device, or a message that is transmitted to a user by a communication channel such as email, text message, or voice output). The RPA module 3216 can generate, as output, data that modifies a behavior of an application (e.g., a command to start, activate, suspend, resume, close, or terminate an application). The RPA module 3216 can generate, as output, data that modifies a behavior of the device or another device (e.g., a command that controls a machine, such as a printer, a camera, a device, or an industrial manufacturing device). The RPA module 3216 can generate, as output, data that reflects an initial, current, or final status of the workflow (e.g., a dashboard that shows a progress of the workflow to completion, or a result of the workflow in combination with the results of other workflows). The RPA module 3216 can generate, as output, one or more events (e.g., notifications to a human, an application, an operating system of the device, or another device as to the progression, completion, and/or results of the workflow). The events can be received and further processed by the RPA module 3216 or another RPA module executing on the same device or another device. For example, upon completion of a first workflow, the RPA module 3216 can initiate a second workflow based on a result and/or output of the first workflow. The RPA module 3216 can generate, as output, documentation of one or more results of the workflow. For example, the RPA module 3216 can update a log to document the results and/or output of the workflow, including one or more errors, exceptions, validation failures that occurred during the workflow.

In embodiments, the RPA module 3216 modifies a workflow based on a performance of the workflow. For example, the RPA module 3216 can request review, by a user, of one or more results of the workflow, including one or more errors, exceptions, validation failures that occurred during the workflow. The RPA module 3216 can deactivate one or more steps or modules of the workflow that resulted in an error, exception, or validation failure. The RPA module 3216 can automatically adjust the workflow to perform future instances of the workflow based on the completed instance of the workflow. For example, the RPA module 3216 can update the workflow to improve an efficiency of the workflow, to add or remove functions to the workflow, to adjust functions of the workflow to perform differently, to log one or more instances and/or parameters of the workflow, and/or to eliminate or reduce one or more logical faults in the workflow. The RPA module 3216 can update one or more artificial intelligence modules 3204 associated with the workflow. For example, the RPA module 3216 can generate or add one or more machine learning models to the workflow to improve processing of the workflow. The RPA module 3216 can remove one or more machine learning models to improve efficiency of the workflow. The RPA module 3216 can redesign and/or retrain one or more machine learning models based on a result of the workflow. The RPA module 3216 can add one or more machine learning models to an existing ensemble of machine learning models.

### Analytics Module

In embodiments, the artificial intelligence modules 3204 may include and/or provide access to an analytics module 3218. In embodiments, an analytics module 3218 is configured to perform various analytical processes on data output from entities or other data sources. In example embodiments, analytics produced by the analytics module 3218 may facilitate quantification of system performance as compared to a set of goals and/or metrics. The goals and/or metrics may be preconfigured, determined dynamically from operating results, and the like. Examples of analytics processes that can be performed by an analytics module 3218 are discussed below and in the document incorporated herein by reference. In some example implementations, analytics processes may include tracking goals and/or specific metrics that involve coordination of activities and demand intelligence, such as involving forecasting demand for a set of relevant items by location and time (among many others).

### Digital Twin Module

In embodiments, artificial intelligence modules 3204 may include and/or provide access to a digital twin module 3220. The digital twin module 3220 may encompass any of a wide range of features and capabilities described herein In embodiments, a digital twin module 3220 may be configured to provide, among other things, execution environments for and different types of digital twins, such as twins of physical environments, twins of robot operating units, logistics twins, executive digital twins, organizational digital twins, role-based digital twins, and the like. In embodiments, the digital twin module 3220 may be configured in accordance with digital twin systems and/or modules described elsewhere throughout the disclosure. In example embodiments, a digital twin module 3220 may be configured to generate digital twins that are requested by intelligence clients 3236. Further, the digital twin module 3220 may be configured with interfaces, such as APIs and the like for receiving information from external data sources. For instance, the digital twin module 3220 may receive real-time data from sensor systems of a machinery, vehicle, robot, or other device, and/or sensor systems of the physical environment in which a device operates. In embodiments, the digital twin module 3220 may receive digital twin data from other suitable data sources, such as third-party services (e.g., weather services, traffic data services, logistics systems and databases, and the like. In embodiments, the digital twin module 3220 may include digital twin data representing features, states, or the like of entities, such as supply chain infrastructure entities, transportation or logistic entities, containers, goods, or the like, as well as demand entities, such as customers, merchants, stores, points-of-sale, points-of-use, and the like. The digital twin module 3220 may be integrated with or into, link to, or otherwise interact with an interface (e.g., a control tower or dashboard), for coordination of supply and demand, including coordination of automation within supply chain activities and demand management activities.

In embodiments, a digital twin module 3220 may provide access to and manage a library of digital twins. Artificial intelligence modules 3204 may access the library to perform functions, such as a simulation of actions in a given environment in response to certain stimuli.

### Machine Vision Module

In embodiments, artificial intelligence modules 3204 may include and/or provide access to a machine vision module 3222. In embodiments, a machine vision module 3222 is configured to process images (e.g., captured by a camera) to detect and classify objects in the image. In embodiments, the machine vision module 3222 receives one or more images (which may be frames of a video feed or single still shot images) and identifies “blobs” in an image (e.g., using edge detection techniques or the like). The machine vision module 3222 may then classify the blobs. In some embodiments, the machine vision module 3222 leverages one or more machine-learned image classification models and/or neural networks (e.g., convolutional neural networks) to classify the blobs in the image. In some embodiments, the machine vision module 3222 may perform feature extraction on the images and/or the respective blobs in the image prior to classification. In some embodiments, the machine vision module 3222 may leverage classification made in a previous image to affirm or update classification(s) from the previous image. For example, if an object that was detected in a previous frame was classified with a lower confidence score (e.g., the object was partially occluded or out of focus), the machine vision module 3222 may affirm or update the classification if the machine vision module 3222 is able to determine a classification of the object with a higher degree of confidence. In embodiments, the machine vision module 3222 is configured to detect occlusions, such as objects that may be occluded by another object. In embodiments, the machine vision module 3222 receives additional input to assist in image classification tasks, such as from a radar, a sonar, a digital twin of an environment (which may show locations of known objects), and/or the like. In some embodiments, a machine-vision module 3222 may include or interface with a liquid lens. In these embodiments, the liquid lens may facilitate improved machine vision (e.g., when focusing at multiple distances is necessitated by the environment and job of a robot) and/or other machine vision tasks that are enabled by a liquid lens.

### Natural Language Processing Module

In embodiments, the artificial intelligence modules 3204 may include and/or provide access to a natural language processing (NLP) module 3224. In embodiments, an NLP module 3224 performs natural language tasks on behalf of an intelligence service client 3236. Examples of natural language processing techniques may include, but are not limited to, speech recognition, speech segmentation, speaker diarization, text-to-speech, lemmatization, morphological segmentation, parts-of-speech tagging, stemming, syntactic analysis, lexical analysis, and the like. In embodiments, the NLP module 3224 may enable voice commands that are received from a human. In embodiments, the NLP module 3224 receives an audio stream (e.g., from a microphone) and may perform voice-to-text conversion on the audio stream to obtain a transcription of the audio stream. The NLP module 3224 may process text (e.g., a transcription of the audio stream) to determine a meaning of the text using various NLP techniques (e.g., NLP models, neural networks, and/or the like). In embodiments, the NLP module 3224 may determine an action or command that was spoken in the audio stream based on the results of the NLP. In embodiments, the NLP module 3224 may output the results of the NLP to an intelligence service client 3236.

In embodiments, the NLP module 3224 provides an intelligence service client 3236 with the ability to parse one or more conversational voice instructions provided by a human user to perform one or more tasks as well as communicate with the human user. The NLP module 3224 may perform speech recognition to recognize the voice instructions, natural language understanding to parse and derive meaning from the instructions, and natural language generation to generate a voice response for the user upon processing of the user instructions. In some embodiments, the NLP module 3224 enables an intelligence service client 3236 to understand the instructions and, upon successful completion of the task by the intelligence service client 3236, provide a response to the user. In embodiments, the NLP module 3224 may formulate and ask questions to a user if the context of the user request is not completely clear. In embodiments, the NLP module 3224 may utilize inputs received from one or more sensors including vision sensors, location-based data (e.g., GPS data) to determine context information associated with processed speech or text data.

In embodiments, the NLP module 3224 uses neural networks when performing NLP tasks, such as recurrent neural networks, long short term memory (LSTMs), gated recurrent unit (GRUs), transformer neural networks, convolutional neural networks and/or the like.

FIG. 35 illustrates an example neural network 3200 for implementing NLP module 3224. In the illustrated example, the example neural network is a transformer neural network. In the example, the transformer neural network 3200 includes three input stages and five output stages to transform an input sequence into an output sequence. The example transformer includes an encoder 3202 and a decoder 3204. The encoder 3202 processes input, and the decoder 3204 generates output probabilities, for example. The encoder 3202 includes three stages, and the decoder 3204 includes five stages. Encoder 3202 stage 1 represents an input as a sequence of positional encodings added to embedded inputs. Encoder 3202 stages 2 and 3 include N layers (e.g., N=6, etc.) in which each layer includes a position-wise feedforward neural network (FNN) and an attention-based sublayer. Each attention-based sublayer of encoder 3202 stage 2 includes four linear projections and multi-head attention logic to be added and normalized to be provided to the position-wise FNN of encoder 3202 stage 3. Encoder 3202 stages 2 and 3 employ a residual connection followed by a normalization layer at their output.

The example decoder 3204 processes an output embedding as its input with the output embedding shifted right by one position to help ensure that a prediction for position i is dependent on positions previous to/less than i. In stage 2 of the decoder 3204, masked multi-head attention is modified to prevent positions from attending to subsequent positions. Stages 3-4 of the decoder 3204 include N layers (e.g., N=6, etc.) in which each layer includes a position-wise FNN and two attention-based sublayers. Each attention-based sublayer of decoder 3204 stage 3 includes four linear projections and multi-head attention logic to be added and normalized to be provided to the position-wise FNN of decoder 3204 stage 4. Decoder 3204 stages 2-4 employ a residual connection followed by a normalization layer at their output. Decoder 3204 stage 5 provides a linear transformation followed by a softmax function to normalize a resulting vector of K numbers into a probability distribution 3206 including K probabilities proportional to exponentials of the K input numbers.

Additional examples of neural networks may be found elsewhere in the disclosure.

### Rules-Based Module

Referring back to FIG. 32, in embodiments, artificial intelligence modules 3204 may also include and/or provide access to a rules-based module 3228 that may be integrated into or be accessed by an intelligence service client 3236. In some embodiments, a rules-based module 3228 may be configured with programmatic logic that defines a set of rules and other conditions that trigger certain actions that may be performed in connection with an intelligence client. In embodiments, the rule-based module 3228 may be configured with programmatic logic that receives input and determines whether one or more rules are met based on the input. If a condition is met, the rules-based module 3228 determines an action to perform, which may be output to a requesting intelligence service client 3236. The data received by the rules-based engine may be received from an intelligence service input source 3232 and/or may be requested from another module in artificial intelligence modules 3204, such as the machine vision module 3222, the neural network module 3214, the ML module 3212, and/or the like. For example, a rule-based module 3228 may receive classifications of objects in a field of view of a mobile system (e.g., robot, autonomous vehicle, or the like) from a machine vision system and/or sensor data from a lidar sensor of the mobile system and, in response, may determine whether the mobile system should continue in its path, change its course, or stop. In embodiments, the rules-based module 3228 may be configured to make other suitable rules-based decisions on behalf of a respective client 3236, examples of which are discussed throughout the disclosure. In some embodiments, the rules-based engine may apply governance standards and/or analysis modules, which are described in greater detail below.

### Intelligence Services Controller and Analysis Management Module

In embodiments, artificial intelligence modules 3204 interface with an intelligence service controller 3202, which is configured to determine a type of request issued by an intelligence service client 3236 and, in response, may determine a set of governance standards and/or analyses that are to be applied by the artificial intelligence modules 3204 when responding to the request. In embodiments, the intelligence service controller 3202 may include an analysis management module 3206, a set of analysis modules 3208, and a governance library 3210.

In embodiments, an intelligence service controller 3202 is configured to determine a type of request issued by an intelligence service client 3236 and, in response, may determine a set of governance standards and/or analyses that are to be applied by the artificial intelligence modules 3204 when responding to the request. In embodiments, the intelligence service controller 3202 may include an analysis management module 3206, a set of analysis modules 3208, and a governance library 3210. In embodiments, the analysis management module 3206 receives an artificial intelligence module 3204 request and determines the governance standards and/or analyses implicated by the request. In embodiments, the analysis management module 3206 may determine the governance standards that apply to the request based on the type of decision that was requested and/or whether certain analyses are to be performed with respect to the requested decision. For example, a request for a control decision that results in an intelligence service client 3236 performing an action may implicate a certain set of governance standards that apply, such as safety standards, legal standards, quality standards, or the like, and/or may implicate one or more analyses regarding the control decision, such as a risk analysis, a safety analysis, an engineering analysis, or the like.

In some embodiments, the analysis management module 3206 may determine the governance standards that apply to a decision request based on one or more conditions. Non-limiting examples of such conditions may include the type of decision that is requested, a geolocation in which a decision is being made, an environment that the decision will affect, current or predicted environment conditions of the environment and/or the like. In embodiments, the governance standards may be defined as a set of standards libraries stored in a governance library 3210. In embodiments, standards libraries may define conditions, thresholds, rules, recommendations, or other suitable parameters by which a decision may be analyzed. Examples of standards libraries may include, legal standards library, a regulatory standards library, a quality standards library, an engineering standards library, a safety standards library, a financial standards library, and/or other suitable types of standards libraries. In embodiments, the governance library 3210 may include an index that indexes certain standards defined in the respective standards library based on different conditions. Examples of conditions may be a jurisdiction or geographic areas to which certain standards apply, environmental conditions to which certain standards apply, device types to which certain standards apply, materials or products to which certain standards apply, and/or the like.

In some embodiments, the analysis management module 3206 may determine the appropriate set of standards that must be applied with respect to a particular decision and may provide the appropriate set of standards to the artificial intelligence modules 3204, such that the artificial intelligence modules 3204 leverages the implicated governance standards when determining a decision. In these embodiments, the artificial intelligence modules 3204 may be configured to apply the standards in the decision-making process, such that a decision output by the artificial intelligence modules 3204 is consistent with the implicated governance standards. It is appreciated that the standards libraries in the governance library may be defined by the platform provider, customers, and/or third parties. The standards may be government standards, industry standards, customer standards, or other suitable sources. In embodiments, each set of standards may include a set of conditions that implicate the respective set of standards, such that the conditions may be used to determine which standards to apply given a situation.

In some embodiments, the analysis management module 3206 may determine one or more analyses that are to be performed with respect to a particular decision and may provide corresponding analysis modules 3208 that perform those analyses to the artificial intelligence modules 3204, such that the artificial intelligence modules 3204 leverage the corresponding analysis modules 3208 to analyze a decision before outputting the decision to the requesting client. In embodiments, the analysis modules 3208 may include modules that are configured to perform specific analyses with respect to certain types of decisions, whereby the respective modules are executed by a processing system that hosts the instance of the intelligence services 3200. Non-limiting examples of analysis modules 3208 may include risk analysis module(s), security analysis module(s), decision tree analysis module(s), ethics analysis module(s), failure mode and effects (FMEA) analysis module(s), hazard analysis module(s), quality analysis module(s), safety analysis module(s), regulatory analysis module(s), legal analysis module(s), and/or other suitable analysis modules.

In some embodiments, the analysis management module 3206 is configured to determine which types of analyses to perform based on the type of decision that was requested by an intelligence service client 3236. In some of these embodiments, the analysis management module 3206 may include an index or other suitable mechanism that identifies a set of analysis modules 3208 based on a requested decision type. In these embodiments, the analysis management module 3206 may receive the decision type and may determine a set of analysis modules 3208 that are to be executed based on the decision type. Additionally or alternatively, one or more governance standards may define when a particular analysis is to be performed. For example, the engineering standards may define what scenarios necessitate a FMEA analysis. In this example, the engineering standards may have been implicated by a request for a particular type of decision and the engineering standards may define scenarios when an FMEA analysis is to be performed. In this example, artificial intelligence modules 3204 may execute a safety analysis module and/or a risk analysis module and may determine an alternative decision if the action would violate a legal standard or a safety standard. In response to analyzing a proposed decision, artificial intelligence modules 3204 may selectively output the proposed condition based on the results of the executed analyses. If a decision is allowed, artificial intelligence modules 3204 may output the decision to the requesting intelligence service client 3236. If the proposed configuration is flagged by one or more of the analyses, artificial intelligence modules 3204 may determine an alternative decision and execute the analyses with respect to the alternate proposed decision until a conforming decision is obtained.

It is noted here that in some embodiments, one or more analysis modules 3208 may themselves be defined in a standard, and one or more relevant standards used together may comprise a particular analysis. For example, the applicable safety standard may call for a risk analysis that can use or more allowable methods. In this example, an ISO standard for overall process and documentation, and an ASTM standard for a narrowly defined procedure may be employed to complete the risk analysis required by the safety governance standard.

As mentioned, the foregoing framework of an intelligence services 3200 may be applied in and/or leveraged by various entities. For example, in some embodiments, a platform-level intelligence system may be configured with the entire capabilities of the intelligence services 3200, and certain configurations of the intelligence services 3200 may be provisioned for respective entities. Furthermore, in some embodiments, an intelligence service client 3236 may be configured to escalate an intelligence system task to a higher-level entity (e.g., edge-level or the platform-level) when the intelligence service client 3236 cannot perform the task autonomously. It is noted that in some embodiments, an intelligence service controller 3202 may direct intelligence tasks to a lower-level component. Furthermore, in some implementations, an intelligence services 3200 may be configured to output default actions when a decision cannot be reached by the intelligence services 3200 and/or a higher or lower-level intelligence system. In some of these implementations, the default decisions may be defined in a rule and/or in a standards library.

### Reinforcement Learning to Determine Optimal Policy

Reinforcement learning (RL), is a machine learning technique where an agent iteratively learns optimal policy through interactions with the environment. In RL, the agent must discover correct actions by trial-and-error so as to maximize some notion of long-term reward. Specifically, in a system employing RL, there exist two entities: (1) an environment and (2) an agent. The agent is a computer program component that is connected to its environment such that it can sense the state of the environment as well as execute actions on the environment. On each step of interaction, the agent senses the current state of the environment, s, and chooses an action to take, a. The action changes the state of the environment, and the value of this state transition is communicated to the agent by a reward signal, r, where the magnitude of r indicates the desirability of an action. Over time, the agent builds a policy, x, which specifies the action the agent will take for each state of the environment.

Formally, in reinforcement learning, there exists a discrete set of environment states, S; a discrete set of agent actions, A; and a set of scalar reinforcement signals, R. After learning, the system creates a policy, π, that defines the value of taking action aεA in state sεS. The policy defines Qπ(s, a) as the expected return value for starting from s, taking action a, and following policy π.

The reinforcement learning agent is trained in a policy through iterative exposure to various states, having the agent select an action as per the policy and providing a reward based on a function designed to reward desirable behavior. Based on the reward feedback, the system may “learn” the policy and becomes trained in producing desirable actions. For example, for navigation policy, RL agent may evaluate its state repeatedly (e.g., location, distance from a target object), select an action (e.g., provide input to the motors for movement towards the target object), evaluate the action using a reward signal, which provides an indication of the of the success of the action. (e.g., a reward of +10 if movement reduces the distance between a mobile system and a target object and −10 if the movement increases the distance). Similarly, the RL agent may be trained in grasping policy by iteratively obtaining images of a target object to be grasped, attempt to grasp the object, evaluate the attempt, and then execute the subsequent iteration using the evaluation of the attempt of the preceding iteration(s) to assist in determining the next attempt.

There may be several approaches for training the RL agent in a policy. Imitation learning is a key approach in which the agent learns from state/action pairs where the actions are those that would be chosen by an expert (e.g., a human) in response to an observed state. Imitation learning not just solves sample-inefficiency or computational feasibility problems, but also makes the training process safer. The RL agent may derive multiple examples of the state/action pairs by observing a human (e.g., navigating towards and grasping a target object), and uses them as a basis for training the policy. Behavior cloning (BC), that focuses on learning the expert's policy using supervised learning is an example of imitation learning approach.

Value based learning approach aims to find a policy comprising a sequence of actions that maximizes the expectation value of future reward (or minimizes the expected cost). The RL agent may learn the value/cost function and then derives a policy with respect to the same. Two different expectation values are often referred to: the state value V(s) and the action value Q(s,a) respectively. The state value function V(s) represents the value associated with the agent at each state whereas the action value function Q(s,a) represents the value associated with the agent at state s and performing action a. The value-based learning approach works by approximating optimal value (V* or Q*) and then deriving an optimal policy. For example, the optimal value function Q*(s, a) may be identified by finding the sequence of actions which maximize the state-action value function Q(s, a). The optimal policy for each state can be derived by identifying the highest valued action that can be taken from each state.

π*(s)=argmax Q*(s,a)

To iteratively calculate the value function as actions within the sequence are executed and the mobile system transitions from one state to another, the Bellman Optimality equation may be applied. The optimal value function Q*(s,a) obeys Bellman Optimality equation and can be expressed as:

$$Q * ( {s}_{t} , {a}_{t} ) = E [ {r}_{t + 1} + γmax Q * ( {s}_{t + 1} , {a}_{t + 1} ) ]$$

Policy based learning approach directly optimizes the policy function x using a suitable optimization technique (e.g., stochastic gradient descent) to fine tune a vector of parameters without calculating a value function. The policy-based learning approach is typically effective in high-dimensional or continuous action spaces.

FIG. 36 illustrates an approach based on reinforcement learning and including evaluation of various states, actions and rewards in determining optimal policy for executing one or more tasks by a mobile system.

At 3302, a reinforcement learning agent (e.g., of the intelligence services system 3300) receives sensor information including a plurality of images captured by the mobile system in the environment. The analysis of one or more of these images may enable the agent to determine a first state associated with the mobile system at 3304. The data representing the first state may include information about the environment, such as images, sounds, temperature or time and information about the mobile system, including its position, speed, internal state (e.g., battery life, clock setting) etc.

At 3306, 3308, and 3310, various potential actions responsive to the state may be determined. Some examples of potential actions include providing control instructions to actuators, motors, wheels, wings flaps, or other components that control the agent's speed, acceleration, orientation, or position; changing the agent's internal settings, such as putting certain components into a sleep mode to conserve battery life; changing the direction if the agent is in danger of colliding with an obstacle object; acquiring or transmitting data; attempting to grasp a target object and the like.

At 3312, 3314 and 3316, expected rewards may be determined for each of the potential actions based on a reward function. For each of the determined potential actions, an expected reward may be determined based on a reward function. The reward may be predicated on a desired outcome, such as avoiding an obstacle, conserving power, or acquiring data. If the action yields the desired outcome (e.g., avoiding the obstacle), the reward is high; otherwise, the reward may be low.

The agent may also look to the future to analyze whether there may be opportunities for realizing higher rewards in the future. At 3318, 3320, and 3322, the agent may determine future states resulting from potential actions respectively at 3306, 3308, and 3310.

For each of the future states predicted at 3318, 3320, and 3322, one or more future actions may be determined and evaluated. At 3324, 3326, and 3328, for example, values or other indicators of expected rewards associated with one or more of the future actions may be developed. The expected rewards associated with the one or more future actions may be evaluated by comparing values of reward functions associated with each future action

At 3330, an action may be selected based on a comparison of expected current and future rewards.

In embodiments, the reinforcement learning agent may be pre-trained through simulations in a digital twin system. In embodiments, the reinforcement agent may be pre-trained using behavior cloning. In embodiments, the reinforcement agent may be trained using a deep reinforcement learning algorithm selected from Deep Q-Network (DQN), double deep Q-Network (DDQN), Deep Deterministic Policy Gradient (DDPG), soft actor critic (SAC), advantage actor critic (A2C), asynchronous advantage actor critic (A3C), proximal policy optimization (PPO), trust region policy optimization (TRPO).

In embodiments, the reinforcement learning agent may look to balance exploitation (of current knowledge) with exploration (of uncharted territory) while traversing the action space. For example, the agent may follow an ε-greedy policy by randomly selecting exploration occasionally with probability ε while taking the optimal action most of the time with probability 1−ε, where ε is a parameter satisfying 0<ε<1.

### Market Orchestration Architecture

Referring to FIG. 37, a block diagram of exemplary features, capabilities, and interfaces of an exemplary deployment environment 3800 of a set of cross market interaction and exchange methods and systems 3810 is depicted. Cross market interaction and exchange methods and systems may be configured as a portion (or portions) of one or more transaction platforms. The exemplary embodiment in FIG. 37 depicts a cross market interaction and exchange method and system 3810 including currency-based value normalization, cross-exchange item value translation, item token generation, rights token generation and the like. Exemplary embodiments of cross market interaction and exchange methods and systems 3810 are depicted and described elsewhere herein. Assets (e.g., items) 3802 may represent one or more sources of asset information, such as item value, item characteristics, item rights, item smart contracts, and the like. In an exemplary transaction platform deployment of the cross market interaction and exchange methods and systems 3810, which is described elsewhere herein in greater detail, asset data may be processed, such as through use of robotic process automation (R P A) 3804, to generate, for example, a normalized asset value, a translated asset value, an asset token, an asset right token, and the like.

In embodiments, cross market interaction and exchange methods and systems 3810 may be configured with or operationally connected to a set of application programming interfaces (APIs) through which, among other things, asset data may be retrieved and/or received. In exemplary embodiments, an API may be an open/standardized API (e.g., banking/financial institution open APIs) that, among other things, may facilitate integration with and into current and emerging ecosystems. Use of open/standardized APIs, while optional, may further enable cross market interaction and exchange methods and systems 3810 to be integrated into a wide range of transaction workflows, such as corporate internal workflows, inter-jurisdiction transaction workflows, and the like.

In example embodiments, market orchestration elements 3808 may facilitate use of cross market interaction and exchange methods and systems 3810 for various aspects of market orchestration, including, without limitations, software orchestrated transactions, software orchestrated marketplaces, and the like. Market orchestration elements 3808 may facilitate deployment of cross market interaction and exchange methods and systems 3810, such as in a web service embodiment, as an integrated function of a market orchestration platform, such as an automated market orchestration system of systems as described herein. In embodiments, cross market interaction and exchange methods and systems 3810 may provide cross market interaction and exchange capabilities for market orchestration when configured as a portion of market orchestration elements 3808 and the like.

The example deployment environment 3800 may include, reference and/or provide cross market interaction capabilities 3810 that may enable leveraging cross market interaction and exchange principals, computation capabilities, storage and data sourcing capabilities, as well as intelligence capabilities for cross market interactions. Cross market interaction capabilities 3810 may include interfaces to one or more marketplaces, transaction environments, and the like, so that, among other things, a data network and infrastructure pipeline 3806 may be configured with assets from one market in a cross market integration deployment as a source of data and with another market in the cross market integration deployment as a target recipient of the data network and infrastructure pipeline services. In embodiments, a similar arrangement may be constructed between two or more markets so that asset data in either market can be used as a data source and can be influenced by asset data from another market. Cross market interactions 3810 may be accomplished through one or more market-to-market data network and infrastructure pipelines for intelligent exchange of asset data among markets, such as data about assets of buyers in one market and about assets of sellers in another.

In the exemplary deployment environment 3800, functions and processes 3812, for an exemplary market-oriented deployment may include software oriented transaction functions and processes, automatic transaction transactions and processes, and the like. Functions and processes 3812 for cross market interaction and exchange methods and systems 3810 may include signaling availability of data (e.g., emergence of an occurrence of asset data) that impacts data provided to a transaction operator from (for example). Other exemplary functions and processes 3812 may include embedding cross market interaction and exchange capabilities into smart contracts, tokens, publishing data on a schedule, or other occurrences (e.g., an initiation of a smart contract and the like). Yet other functions and processes may include payments between/among machines and the like.

In embodiments, cross market interaction and exchange methods and systems may include and/or be associated with cross market interaction and exchange technology enablers 3814, such as 5G networking, artificial intelligence, visualization technology (e.g., VR/AR/XR), distributed ledger, and the like.

In embodiments, cross market interaction and exchange methods and systems 3810 may include and/or leverage cloud-based virtualized containerization capabilities and services 3816, such as without limitation a container deployment and operation controller, such as Kubernetes 3818 and the like. Cloud-based virtualized containers may facilitate cross market interaction and exchange resources being deployed close to asset data, thereby potentially reducing network bandwidth consumption or the potential for network disturbances in a data workflow and without substantive investment in infrastructure by an operator and/or consumer.

The exemplary deployment 3800 may further include business system interfaces 3820, such as APIs and the like that facilitate adoption of cross market interaction and exchange methods and systems by enterprises for development, among other things of a data-centric business workflow environment that enables cross-functional data use, seamless aggregation, and immediate contextualization of corporate data for individual departments, enterprise, subsidiary, and the like. Further integration of aspects of the cross market interaction and exchange methods and systems into enterprise systems may include integration with one or more enterprise databases and the like.

Cross market interaction and exchange enabled markets 3822 may be enabled by and/or enhanced through the adoption of cross market interaction and exchange technology. Markets, such as markets at an intersection of financial service and physical product offerings may be revealed and/or enabled through application of this technology to help parse, analyze, and provide intelligence for a wide range of market-impacting and/or related assets. These emergent markets may be substantively constructed as a result of application of cross market interaction and exchange techniques within or in association with individual markets, and the like.

Technologies that may be provided by and/or enabled by cross market interaction and exchange methods and systems 3810 may include intelligence services 3824, such as artificial intelligence, machine learning and the like. These intelligence services 3824 may be provided in the environment 3800, or accessed (e.g., as third-party services) via one or more interfaces of the environment 3800. The cross market interaction and exchange methods and systems may be provided access to these intelligence services 3824. One or more cross market interaction and exchange methods and systems 3810 may bring to the platform its own set of intelligence services, which may be dedicated to a host cross market interaction and exchange system, or may be shareable among linked systems, for example.

In the exemplary embodiment of FIG. 37, transaction/market oriented capabilities, services, and deployment may include market platforms 3826, transaction flows 3828, buyers 3832, sellers 3831, and transaction/marketplace specific data network and infrastructure pipelines that enrich transactions, transaction services and the like 3830. For multi-party transaction environments, a plurality of cross market interaction and exchange methods and systems 3810 may be configured and operated to satisfy a range of consumer needs for market analysis, transaction efficiencies, cost containment, buy/sell decisions and the like.

Normalization within a Set of Items

Referring to FIG. 38, computer-implemented methods and systems for automated orchestration of one or more marketplaces may include a set of robotic process automation services that are configured to state the value of a set of items that are represented in a plurality of exchanges, such that representation of the value of each member of the set of items in the plurality of exchanges is normalized based on the native currencies of the respective exchanges. A robotic process automation-enabled platform for item value normalization 3900 as depicted in FIG. 38 may receive information for a plurality of items 3902 that may be available for transaction in a plurality of exchanges. The plurality of items may include sets of items. Items within a set may be available for transaction in one or more of the plurality of exchanges. Each set of items may be available for transactions in one more of the plurality of exchanges as a set, such as a complete set (all items in a set), a partial set (a subset of items from the set), a hybrid set (combinations of items from two or more sets), and the like. Transactions of the one or more sets (and/or items in a set) may be bound by aspects of exchanges in which a transaction occurs. In an example, two exchanges may conduct transactions in two distinct currencies. While jurisdiction-specific currencies are contemplated, different currencies within and/or across jurisdictions are also contemplated, such as various types of cryptocurrencies, conventional currencies, and the like. As an example, a first exchange may value items in a currency, such as USD. Transactions for items in the first exchange may occur using USD. In addition to item values being based on an exchange-specific currency, fees (optional and/or mandatory) of an exchange (e.g., any of a range of fees that an exchange may charge in association with a transaction, some of which are described herein) may be based on the exchange-specific currency. In example embodiments, exchange fees may be based on an item value (e.g., a sales fee of x % of a transaction amount is charged to a transaction participant of the transaction). A second exchange (optionally within the jurisdiction of the first exchange) may value items in a virtual currency, such as a form of cryptocurrency and the like. Items, services, transaction fees, and the like may also be based on one or more cryptocurrencies of the second exchange.

A transaction orchestration platform, such as a may be described herein may include capabilities for orchestrating transactions, such as analysis, prediction, contracting services, and the like. Fees for these possibly optional services may also be aligned with an exchange-specific currency.

Transaction participants (e.g., item buyers and sellers and the like), exchange operators, transaction orchestrators, and other transaction facilitators may benefit from normalizing item values for sets of items that may be transacted through exchanges with distinct currencies. While cross-currency exchange rates may help participants determine some costs for exchanges with different currencies, normalizing item values may allow participants in a plurality of exchange-currency specific exchanges to determine aspects of item value, such as relative values and the like. Examples of a form of item value normalization across a plurality of exchanges is depicted in FIG. 38. The item value normalization platform 3900 may process item values for a plurality of sets of items 3902 to deliver a normalized value for items within the set. The item value normalization platform 3900 may deliver a normalized value for items within the set that are further normalized for a plurality of currencies of the exchanges. In an example, value of items in a first set of items maybe normalized within the set for a plurality of exchange currencies, such as normalized values of items of SET A may be normalized for a currency of exchange X 3904 and for a currency of exchange Y 3906. A range of normalization approaches may be applied. An exemplary approach involves normalizing values for items in a set against one of the items in the set (e.g., a reference item), so that a value of each item is represented relative to reference item value. Item value normalization within a set may further include normalization for item value for a given currency. In an example, values of items in the SET A may be based on a first currency (a reference currency). The normalized value of items in SET A for the reference currency may be processed by the platform 3900 for a second currency (e.g., exchange Y currency) to produce normalized values of items in SET A against the reference item for exchange Y currency.

An item normalization system 3908 may process item values (e.g., reference item values and the like) for a plurality of currencies; thereby producing a plurality of currency-specific normalized item values for items in a set against a reference item value. In the example of the embodiments depicted by FIG. 38, a plurality of sets of items 3902 (e.g., item set A represented by items A1, A2, and A3, item set B represented by items B1, B2, and B3, and item set C represented by items C1, C2, and C3) may be processed by the item in a set normalization for a currency system 3908. Representative items in one or more of the exemplary plurality of sets of items (Sets A, B, and C) may be processed for normalization of values within a set, thereby producing, for example, a plurality of item value normalized currency-specific item sets. In the embodiments of FIG. 38, exemplary sets A, B, and C may be processed for normalization for exchange X currency 3904 to produce item sets (item value sets) AX, BX, and CX 3912. Likewise, exemplary item sets A, B, and C may be processed for normalization within exchange Y currency 3906 to product items sets AY, BY, and CY 3914.

Normalization of item values within an item set, and optionally within a plurality of item sets, may include identifying one of the items in each set to be normalized as a reference item. In example embodiments, item A1 may be identified as a reference item for item value normalization of items within item set A. Item B2 may be selected for set B, and so forth so that at least one item is selected as a reference item for item value normalization in each set of items to be processed for item value normalization.

Determination of a reference item in a set (or a plurality of item sets) may be based on factors, such as item value in a given currency (e.g., the lowest valued item in the given currency). A reference item determination factor may include an item transaction history. Items with measurable transaction history may be valued based on marketplace factors, such as an exchange participant's perception of item value. Therefore, use of item transaction history may provide a value basis that may align well with a likely exchange value for the item, which may suggest exchange value for other items in the set. A reference item determination factor may include a degree of commonality of an item to other items in a set. As an example, if an item shares features, physical aspects, capabilities, and the like with a majority of other items in a set, designating it as a reference item may facilitate determining relative values for other items in the set based on, for example, differences, such as more or few features than such a reference item. Yet another reference item determination factor may be a degree of interest in the item, such as by exchange participants or by other measures (e.g., social media expressed interest and the like). Selecting a popular item as a reference item may enable value normalization of other, potentially less popular items in a set.

Further, an item selected as a reference item in a first set for a first currency may be different than an item selected as a reference item in the first set for a second currency. In an example, due at least in part to currency exchange rates, an item in a first currency with a value that is below a minimum monetary unit in a second currency may be preferred as a reference item in the first currency but not for the second currency, due at least in part to avoiding fractional valued items as reference items. Likewise, an item selected as a reference item for an item set in a first exchange may be different than an item selected as a reference item in the item set in a second exchange. Exchange factors that may impact selection of a reference item may include regional/jurisdictional differences, exchange participant preferences and the like.

The example embodiments depicted in FIG. 38 may include automation of item value normalization actions, such as those described herein as being performed by and/or enabled by the item normalization system 3908 and the like. Automation may be provided by and/or enabled by robotic process automation techniques as may be performed by a robotic process automation system 3910. The robotic process automation system 3910 may include capabilities, features, structures, methods, algorithms, techniques for learning, human activity emulation, and the like that may be similar to other robotic process automation systems described herein. In the embodiments of FIG. 38, the robotic process automation system 3910 may preform normalization of values of items in a plurality of sets of items, including, for example, selection of a reference item in an item set, normalization of values of other items in the item set, selection of a reference item in a plurality of item sets, normalization of values of other items in the plurality of items sets, and the like. As an example, normalization of items B1, B2, and B3 of item set B (in the plurality of item sets 3902) for exchange currency Y 3906 may be performed through application of automation capabilities of the robotic process automation system 3910, optionally without human intervention. In example embodiments, the robotic process automation system 3910 may autonomously perform item value normalization for one or more items in a set of items for one or more currencies, such as currencies associated with one or more exchanges (e.g., exchange X currency 3904 and/or exchange Y currency 3906).

### Normalization Across Sets of Items

Referring to FIG. 39, computer-implemented methods and systems for automated orchestration of one or more marketplaces may include a set of robotic process automation services that are configured to state the value of a set of items that are represented in a plurality of exchanges, such that representation of the value of each member of the set of items in the plurality of exchanges is normalized based on the native currencies of the respective exchanges. A robotic process automation-enabled platform for item value normalization 4000 as depicted in FIG. 39 may receive information for a plurality of items 4002 that may be available for transaction in a plurality of exchanges. The plurality of items may include sets of items. Items within a set may be available for transaction in one or more of the plurality of exchanges. Each set of items may be available for transactions in one more of the plurality of exchanges as a set, such as a complete set (all items in a set), a partial set (a subset of items from the set), a hybrid set (combinations of items from two or more sets), and the like. Transactions of the one or more sets (and/or items in a set) may be bound by aspects of exchanges in which a transaction occurs. In an example, two exchanges may conduct transactions in two distinct currencies. While jurisdiction-specific currencies are contemplated, different currencies within and/or across jurisdictions are also contemplated, such as various types of cryptocurrencies, conventional currencies, and the like. As an example, a first exchange may value items in a currency, such as USD. Transactions for items in the first exchange may occur using USD. In addition to item values being based on an exchange-specific currency, fees (optional and/or mandatory) of an exchange (e.g., any of a range of fees that an exchange may charge in association with a transaction, some of which are described herein) may be based on the exchange-specific currency. In example embodiments, exchange fees may be based on an item value (e.g., a sales fee of x % of a transaction amount is charged to a transaction participant of the transaction). A second exchange (optionally within the jurisdiction of the first exchange) may value items in a virtual currency, such as a form of cryptocurrency and the like. Items, services, transaction fees, and the like may also be based on one or more cryptocurrencies of the second exchange.

Transaction participants (e.g., item buyers and sellers and the like), exchange operators, transaction orchestrators, and other transaction facilitators may benefit from normalizing item values for sets of items that may be transacted through exchanges with distinct currencies. While cross-currency exchange rates may help participants determine some costs for exchanges with different currencies, normalizing item values may allow participants in a plurality of exchange-currency specific exchanges to determine aspects of item value, such as relative values and the like. Examples of a form of item value normalization across a plurality of exchanges are depicted in FIG. 39. The item value normalization platform 4000 may process item values for a plurality of item sets 4002 to deliver a normalized value for items across the plurality of item sets. The item value normalization platform 4000 may deliver a normalized value for items across the plurality of item sets that are further normalized for a plurality of currencies of exchanges for which item value normalization is requested. In an example, value of items in a first set of items maybe normalized across a plurality of item sets for a plurality of exchange currencies, such as normalized values of items across SETs A, B, and C may be normalized for a currency of exchange X 4004 and for a currency of exchange Y 4006. A range of normalization approaches may be applied for both cross-set item value normalization for a single currency as well as for cross-set item value normalization for multiple currencies. An exemplary approach involves normalizing values for items in a first set against one or more of items in a second set (e.g., a reference set), so that a value of each item in the first set is represented relative to the one or more items in the reference set. Item value normalization across item sets may further include normalization for item value for a given currency. In an example, values of items in the SET A may be based on a first currency (a reference currency). The normalized value of items in SET A for the reference currency may be processed by the platform 4000 for a second currency (e.g., exchange Y currency) to produce normalized values of SET A items against the reference set for exchange Y currency.

An item normalization system 4008 may process item values (e.g., reference set item values and the like) for a plurality of currencies; thereby producing a plurality of currency-specific normalized item values for items in a set against a reference set. In the example of the embodiments depicted by FIG. 39, a plurality of sets of items 4002 (e.g., item set A represented by items A1, A2, and A3, item set B represented by items B1, B2, and B3, and item set C represented by items C1, C2, and C3) may be processed by cross-set item value normalization system 4008. Representative items in one or more of the exemplary plurality of sets of items (Sets A, B, and C) may be processed for normalization of values across the item sets, thereby producing, for example, a plurality of item value normalized currency-specific item sets. In the embodiments of FIG. 39, exemplary sets A, B, and C may be processed for normalization for exchange X currency 4004 to produce item sets (item value sets) AX, BX, and CX 4012. In this example, values of items in sets B and C are normalized for currency X against values of items in reference set A. Likewise, exemplary item sets A, B, and C may be processed for normalization within exchange Y currency 4006 to product items sets AY, BY, and CY 4014. In this example, values of items in sets A and C are normalized, for currency Y against values of items in reference set B.

Normalization of item values across item sets may include identifying one of the item sets in the plurality of item sets to be normalized as a reference item set. In example embodiments, one or more items in item set A, including any or all of the items in item set A, may be identified as a member of a reference set for item value normalization of items across a plurality of sets. Items in set B may alternatively be selected as items in a reference, and so forth.

Determination of a reference set may be based on factors, such as item values for a set in a given currency (e.g., the lowest valued set in the given currency). A reference set determination factor may include an item set transaction history. Item sets with a measurable transaction history may be valued based on marketplace factors, such as an exchange participant's perception of item set value. Therefore, use of item set transaction history may provide a value basis that may align well with a likely exchange value for item set, which may suggest an exchange value for other item sets in the plurality of item sets. A reference set determination factor may include a degree of commonality of a items in a set to items in other sets. As an example, if items in a first set share features, physical aspects, capabilities, and the like with a majority of other items in other item sets, designating the first set as a reference set may facilitate determining relative values for other items in other sets based on, for example, differences, such as more or few features than items in the reference set. Yet another reference set determination factor may be a degree of interest in one or more of the items in the set (and/or the set as a whole), such as by exchange participants or by other measures (e.g., social media expressed interest and the like). Selecting a popular item set as a reference set may enable value normalization of other, potentially less popular item sets.

Further, an item set selected as a reference set for a first currency may be different than a set selected as a reference set for a second currency. In an example, due at least in part to currency exchange rates, an item set in a first currency with a value that is below a minimum monetary unit in a second currency may be preferred as a reference set in the first currency but not for the second currency, due at least in part to avoiding fractional valued item sets as reference sets. Likewise, an item set selected as a reference set in a first exchange may be different than an item set selected as a reference set in a second exchange. Exchange factors that may impact selection of a reference set may include regional/jurisdictional differences, exchange participant preferences and the like.

The example embodiments depicted in FIG. 39 may include automation of item value normalization actions, such as those described herein as being performed by and/or enabled by the item normalization system 4008 and the like. Automation may be provided by and/or enabled by robotic process automation techniques as may be performed by a robotic process automation system 4010. The robotic process automation system 4010 may include capabilities, features, structures, methods, algorithms, techniques for learning, human activity emulation, and the like that may be similar to other robotic process automation systems described herein. In the embodiments of FIG. 39, the robotic process automation system 4010 may preform normalization of values of items across a plurality of sets of items, including, for example, selection of a reference set, normalization of values of other items in the plurality of item sets, and the like. As an example, normalization of items B1, B2, and B3 of item set B (in the plurality of item sets 4002) for exchange currency Y 4006 may be performed through application of automation capabilities of the robotic process automation system 4010, optionally without human intervention. In example embodiments, the robotic process automation system 4010 may autonomously perform item value normalization for one or more items across a plurality of item sets for one or more currencies, such as currencies associated with one or more exchanges (e.g., exchange X currency 4004 and/or exchange Y currency 4006).

### Normalization Across Currencies

Referring to FIG. 40, computer-implemented methods and systems for automated orchestration of one or more marketplaces may include a set of robotic process automation services that are configured to state the value of a set of items that are represented in a plurality of exchanges, such that representation of the value of each member of the set of items in the plurality of exchanges is normalized based on and optionally across the native currencies of the respective exchanges. A robotic process automation-enabled platform for item value normalization 4100 as depicted in FIG. 40 may receive information for a plurality of sets of items 4102 and 4103 that may be available for transaction in a plurality of exchanges. The information may include exchange currency-specific item values and the like. Items within a set may be available for transaction in one or more of the plurality of exchanges. Each set of items may be available for transactions in one more of the plurality of exchanges as a set, such as a complete set (all items in a set), a partial set (a subset of items from the set), a hybrid set (combinations of items from two or more sets), and the like. Transactions of the one or more sets (and/or items in a set) may be bound by aspects of exchanges in which a transaction occurs. In an example, two exchanges may conduct transactions in two distinct currencies. While jurisdiction-specific currencies are contemplated, different currencies within and/or across jurisdictions are also contemplated, such as various types of cryptocurrencies, conventional currencies, and the like. As an example, a first exchange may value items in a first currency, such as USD. Further, transactions for items in the first exchange may occur using USD. A second exchange may support transactions, item values, and the like in both USD and cryptocurrencies. In addition to item values being based on an exchange-specific currency, fees (optional and/or mandatory) of an exchange (e.g., any of a range of fees that an exchange may charge in association with a transaction, some of which are described herein) may be based on the exchange-specific currency. In example embodiments, exchange fees may be based on an item value (e.g., a sales fee of x % of a transaction amount is charged to a transaction participant of the transaction). A second exchange (optionally within the jurisdiction of the first exchange) may value items in a virtual currency, such as a form of cryptocurrency and the like. Items, services, transaction fees, and the like may also be based on one or more cryptocurrencies of the second exchange. In example embodiments, item values for transactions in an exchange may be expressed for a plurality of currencies when more than one currency is supported by the exchange. Likewise, values for each item and/or each set of items that are transactable through a plurality of exchanges may be expressed in a plurality of exchange currencies. In the embodiments of FIG. 40, values for item sets 4102 may be expressed in exchange X currency units. In this example, values for items in set AX in the plurality of sets 4102 may be stated as AX1 for item A1, AX2 for item A2, AX3 for item A3, and the like. Likewise, values for item sets 4103 may be expressed in exchange Y currency units (e.g., a value for item A1 of set AY may be stated as AY1, etc.).

Transaction participants (e.g., item buyers and sellers and the like), exchange operators, transaction orchestrators, and other transaction facilitators may benefit from normalizing item values for items in sets of items that may be transacted through exchanges with distinct currencies. While cross-currency exchange rates may help participants determine some costs for exchanges with different currencies, normalizing item values in and across exchange currencies may allow participants in a plurality of exchange-currency specific exchanges to determine aspects of item value, such as normalized item relative values within and across exchanges and the like. Examples of a form of item value normalization across a plurality of exchanges is depicted in FIG. 40. The item value normalization platform 4100 may process item values for a plurality of item sets 4102 and 4103 to deliver a normalized value for items across a plurality of currencies (and optionally within an item set and/or across item sets. The item value normalization platform 4100 may deliver a normalized value for items across the plurality of currencies that may be further normalized with currencies of exchanges for which item value normalization is requested. In an example, currency-specific (e.g., exchange currency-specific) value of one or more items in one or more item sets of items maybe normalized across a plurality a plurality of other exchange currencies. In the example, exchange X currency-specific values of items in one or more of SETs AX, BX, and CX 4102 may be normalized for a currency of exchange Y 4106; thereby producing cross-currency normalized item sets AX(Y), BX(Y), and CX(Y) 4112. Similarly, exchange Y currency-specific value of items in one more of sets AY, BY, and CY 4103 may be normalized for currency of exchange X 4104; thereby producing cross-currency normalized item sets AY(X), BY(X), and CY(X) 4114. Specifically, value of item A1 of set A may be stated as AX1 for currency X and may be stated as AY1 for currency Y. When cross-currency normalization is performed by item normalization across currencies system 4108, item A1 X currency value AX1 can be normalized based on currency Y to product item value AX(Y)1. In example embodiments, any of item values in the set of items 4102 may be normalized for currency X. Likewise, any of item values in the set of items 4103 may be normalized for currency Y. Therefore, item normalization across currencies system 4108 may process normalized item values and/or non-normalized item values when generating cross-currency normalized item values stated in item value sets 4112 and/or 4114.

A range of normalization approaches may be applied for item value normalization for and/or across multiple currencies. An exemplary approach involves normalizing values for items in a one or more item sets for a given currency (e.g., a reference currency) so that a value of each item is represented relative to the reference currency. In the example of FIG. 40, values of items in the SET A may be stated for a plurality of reference currencies. Value of items in item sets 4102 may be stated for currency X, which may be a first reference currency. Likewise, values of items in item set 4103 may be stated for currency Y, which may be a second reference currency. The value of items in SET A for the first reference currency (X) may be processed by the platform 4100 for a second currency (e.g., exchange Y currency) to produce normalized values of SET A items against the reference currency for exchange Y currency 4112. Similarly, the value of items in SET A for the second reference currency (Y) may be processed by the platform 4100 for a second currency (e.g., exchange X currency) to produce normalized values of SET A items against the reference currency for exchange X currency 4114.

Normalization of item values across currencies may include identifying one of the currencies as a reference currency. The example embodiments of FIG. 40 suggests either currency X or currency Y as a reference currency. However, a currency other than a currency in which item values are stated and other than a currency in which item values are to be normalized may be identified as a reference currency. In an example, currency X and currency Y may be currencies used to state item values and for use in an exchange for transacting items. A reference currency may be selected (e.g., currency Z). A statement of relationship among the currencies, or at least between reference currency Z and each of currencies X and Y may be applied when performing cross-currency normalization to achieve currency-specific normalization for use in one or more exchanges. A statement of relationship may include a currency exchange rate, and the like.

Determination of a reference currency may be based on factors, such as stability of a currency that may be determined from currency exchange history, futures values, volatility score, geopolitical factors, and the like. Determination of a reference currency may be based exchange rates and/or costs for exchanging currencies. As an example, if an exchange rate for currency X into a plurality of currencies, is favorable over an exchange rate for currency Y for the plurality of currencies, currency X may be selected as a reference currency. Another example of determination of a reference currency may be based on support for the currency by a given exchange. In this example, referring to FIG. 40, currency X 4104 may be selected as a reference currency for normalizing item values for exchange X and currency Y 4106 may be selected as a reference currency for normalizing item values for exchange Y. In this way, the item value normalization across currencies system 4108 may process item values differently for different exchanges, due at least in part to currency support of each different exchange.

Further, currency may be selected as a reference currency due at least in part to relative currency valuation. If, a minimum monetary unit of a first currencies is greater than a minimum monetary unit of a second currency, the second currency may be selected as the reference currency so that normalized values may be expressed in terms of multiples of the reference currency (rather than fractions of the reference currency).

The example embodiments depicted in FIG. 40 may include automation of item value normalization actions, such as those described herein as being performed by and/or enabled by the item normalization system 4108 and the like. Automation may be provided by and/or enabled by robotic process automation techniques as may be performed by a robotic process automation system 4110. The robotic process automation system 4110 may include capabilities, features, structures, methods, algorithms, techniques for learning, human activity emulation, and the like that may be similar to other robotic process automation systems described herein. In the embodiments of FIG. 40, the robotic process automation system 4110 may preform normalization of values of items across currencies, including, for example, selection of a reference currency, normalization of values of items relative to the reference currency, and the like. As an example, normalization of values for items in set 4102 across exchange X currency 4104 and/or exchange Y currency 4106 may be performed through application of automation capabilities of the robotic process automation system 4110, optionally without human intervention. In example embodiments, the robotic process automation system 4110 may autonomously perform item value normalization for one or more items across a plurality of currencies, such as currencies associated with one or more exchanges (e.g., exchange X currency 4104 and/or exchange Y currency 4106).

### Value Translation

In embodiments, provided herein are computer-implemented methods and systems for automated orchestration of one or more marketplaces, such methods and systems are provided having a set of robotic process automation services that are configured to automatically translate the value of an item represented in a first exchange into a value of the item for representation in a second exchange. Item value representation may include a range of aspects of value, such as an exchange currency value (e.g., an amount of a currency of an exchange in which the items is being represented that a participant in the exchange may ascribe to an item). This aspect of value may be represented as a sale price, a purchase price, or generally an amount for changing (temporarily, conditionally, permanently, or otherwise) one or more rights (e.g., ownership rights) of the item. Such an aspect of value may be represented as a plurality of aspect-related values. IN an example, a value for taking ownership of an item may be different (e.g., involve a different amount of an exchange currency) than a value for a limited use of the item, which may be different than other aspects of value of an item. Further, a value, such as an amount of an exchange currency to participate in a transaction of/for the item (e.g., purchase the item) may vary relative to a currency of a different exchange. Therefore value translation for representation of a value in a first exchange of an item into a value in a second exchange of an item may involve more than merely converting from a first exchange currency to a second exchange currency.

Further, a value of an item may be based on a wide range of factors and therefore may be impacted by more than just currency exchange rates. In example embodiments, a value of an item may be a multi-dimensional currency-based value, such as a transaction cost plus an ongoing cost, such as to operate/use/consume the item over time. An automobile may be an example of such an item for which a value includes both a purchase value and an operating value. Ongoing value of an item may include financing terms (e.g., if a buyer finances a transaction for an item, fees of financing may impact the value). Ongoing costs may vary from one exchange jurisdiction to another, thereby impacting translation of a value of an item from one exchange to another. In an example, fuel-related costs in a first jurisdiction may be higher or lower than those in a second jurisdiction. Therefore, translating value for an item in an exchange of a low fuel cost jurisdiction to be represented in an exchange of a high fuel cost jurisdiction may take into consideration differences in fuel costs. Many other ongoing costs may factor into translation of a value of an item.

Robotic process automation-based value translation may include translation of aspects of value of an item that may be time-dependent, such as an expiration date, a production sequence (e.g., serial) number of the item, and the like. In example embodiments, time-dependent value aspects may be determined from one or more algorithms that take into account time variation when determining value of an item. An example of time-dependent value translation may include market-based changes in currency exchange between the currencies of two exchanges. Representing a value of an item in a target exchange (e.g., that supports a target currency), where the item value is translated from an originating exchange (e.g., that supports an originating currency) may require dynamic representation based on ongoing currency exchange variation. Further, independent of currency variation, an originating exchange value for an item may vary due to a range of factors that may be outside of direct control of the exchange, such as quality reports for comparable items transacted in the originating exchange. Therefore, as a representation of originating exchange item value varies, translation of the item value from the originating exchange item value for presentation in a target exchange may dynamically make a corresponding change in a target exchange value.

In example embodiments, translation of item value from a first exchange for representation of item value in a second exchange may include dependencies, such as volume dependencies, jurisdiction rule dependencies, market-specific (e.g., costs) dependencies (e.g., tariffs, and the like). Volume, such as a relative volume of an item available in an exchange may impact translation of value from a first exchange to a second exchange. As an example, a volume of available product in first exchange (from which item value is being translated) may be limited. A volume of available product in a second exchange (to which item value is being translated) may not be limited, at least not comparably to volume limits of the first exchange. Translation of item value in such a situation may result in a volume-based adjustment in item value during translation. In this example, a value in a first exchange of the item may, based on supply and demand pricing principles generally, not directly translate based on currency exchange rates. Rather, due to greater availability of the item in the second exchange, a translated value for the item may result in a value that is lower (potentially substantively lower) might be suggested based on currency exchange rates.

In example embodiments, tariffs may impact item value translation. Tariffs imposed on items being moved from a first jurisdiction (e.g., where an item is available for transaction in a first exchange) to a second jurisdiction (e.g., where the item is desired to be transacted) may impact translation of value of the item. One such impact may be adding the value of the tariff to the value of the item as part of value translation. Generally, a nature of tariffs is that they are no evenly applied across all types of items even from a single jurisdiction. Therefore, translation of value of an item may include determining if a tariff applies, the amount of the tariff, and conditions for imposing the tariff (e.g., a non-profit buyer may not pay the full tariff).

In embodiments, translation of value of an item from a first exchange to represent a value of the item in a second exchange may include conditional value factors. In example embodiments, conditional value factors may be outside of a control sphere of the second exchange. Aspects, such as seasonal factors, weather factors, geopolitical stability, and the like may impact a representation of value of an item. In an example for an impact of seasonal factors on value, an item that provides essential features for one season (e.g., a thermally insulated coat for a Winter season) may have a representation of value in a first exchange based on the seasonal conditions locally for the first exchange (e.g., northern climates during Winter). Translating a value for this item to a second exchange (e.g., where the local season is Summer) may impact (e.g., reduce) a represented value for the item in the second exchange more substantively than may occur due to currency exchanges rates, for example. Geopolitical factors may impact item value translation. In example embodiments, risks of timely delivery of an item represented in a first jurisdiction that lacks political stability to a recipient in a second jurisdiction where a transaction for the item occurs at least in part in an exchange in the second jurisdiction may impact a translation of value of an item. In an example, an operator of the exchange in the second jurisdiction may require imposing additional fees in such cases (e.g., to secure timely transfer, and the like), thereby impacting the translation of value of the item.

In example embodiments, translation of value of an item from a representation of value of an item in a first exchange to represent a value for an item in a second exchange may include exchange-based factors. Exchange-based factors may include, exchange fees (e.g., overhead associated with transactions for items in an exchange), value-impacting conditions (e.g., compulsory insurance), and the like. Translation of value of an item represented in a high-overhead exchange may factor differences in exchange overhead when representing a value in a low-overhead exchange. Translation of value may, in this regard, consider and evaluate contributors to item value differently based on exchange. Whereas a core value of an item may be one contributor to a representation of item value in a first exchange, exchange overhead for the item in the first exchange may be separated from the representation of value during value translation. In an example, a currency exchange rate-based factor may be applied to the core value, and a target exchange overhead may supplement the translated core value to arrive at a representation of value of the item in the target exchange, leaving the first exchange high overhead out of the final representation of value translation.

For translation of value of multiple similar items, aspects that differentiate the otherwise similar items may impact value translation. In an example, translation of value of bottles of wine may vary substantively based on, for example, vintage of individual bottles. Value for a case of wine with mixed vintage bottles (or a collection of items grouped into a set of mixed vintage bottles of wine) may be translated differently than for single vintage bottles (e.g., where a single translation factor may be applied to each of the bottles). In another example, translating a value of identical items from a production line may be impacted by aspects of the items, such as a serial number of the item. A first serial number, a milestone-type serial number (e.g., 1,000,000), a final production serial number, and the like may be valued differently than other items from the production run. In example embodiments, determining such aspects of items for value translation may provide improved value translation for representation of an item value in a target exchange.

Item value may further be based on a perception of a participant in a transaction for the item. In a simple example, a value of an item to a buyer may be different than a value to a seller of the item. In example embodiments, taxation may impact an exchange participant differently in different exchanges. A value to an exchange participant in a first exchange may include no sales tax, whereas a sales tax may be imposed on transactions conducted in a target exchange. Therefore, value translation may factor tax treatment of transactions in the two exchanges into a representation of value. Another miscellaneous value that may impact an exchange participant's perception of value may include access to credit/funding, such as with favorable borrower terms for conducting transactions in an exchange. Translating a representation of value of an item in a first exchange that includes one or more of these factors that are different from value-impacting factors of target exchange may include adaptation of a representation of a value of the item in the target exchange to include such supplemental value aspects.

Item value for translation among exchanges may include post-transaction value. An example of such value differentiation may include post-transaction value. Post-transaction value for items transacted in a first exchange may include residual income based on use of the item. In a second exchange, post-transaction value may be derived from accrual of energy/carbon credits based on item use. Yet another example of post-transaction value that may impact value translation may include benefits to, for example a seller for use of an exchange. A value to a seller in a first exchange may include advertising/promotional credits for future use with the exchange. One such example credit may include access to social media influencers associated with the exchange. A post-transaction value to a seller in a second exchange may include accrual of credits toward exchange fees that may be used by the seller, transferred to other sellers, and the like. Yet another example of post-transaction factors that may impact value translation may include transaction fee basis differences. A transaction fee may be applied to a transaction at the successful conclusion of the transaction (e.g., the buyer releases funds to the seller). In a first exchange the fee may be transaction amount-based; in a second exchange the may be fixed or at least partially independent of the transaction amount.

### Item Value Translation

Referring to FIG. 41, embodiments are depicted of a set of robotic process automation services that are configured to automatically translate the value of an item represented in a first exchange into a value of the item for representation in a second exchange. The left side of the figure generally depicts a first exchange value representation; the right side generally depicts a second or target exchange item value representation. For discussion of the embodiments of FIG. 41, a first exchange may include Exchange X 4302; a second/target exchange may include Exchange Y 4204. Value translation may be performed by a value translation system 4210. The value translation system 4210 may access exchange X metadata 4206 that may include one or more of the factors described above, such as transaction fees, access to funding, meaning of terminology, historical treatment of some factors, supported currencies, and the like that are associated with item value representation associated with Exchange X 4202. The value translation system 4210 may access a comparable data store of exchange item value representation associated metadata 4208 for exchange Y 4204. The value translation system 4210 may, among other things, process the exchange metadata (e.g., X exchange metadata 4206 and/or Y exchange metadata 4208, or portions thereof) to develop an understanding of how X exchange item value representation compares and/or relates to Y exchange item value representation. In an example, the value translation system 4210 may determine from such processing that exchange overhead that may be represented in item values for exchange Y may be a multiple of exchange overhead for exchange X. This value translation-impacting determination may be based using a comparative process for overhead values stated for each exchange, (e.g., 1% for exchange X and 1.2% for exchange Y). Determining one or more relationships of exchange overhead to item value representation for translating value may include parsing descriptive information (e.g., Exchange X overhead description: “An exchange transaction fee of one percent of transaction amount is included in each transaction”; exchange Y overhead description: “Participants are required to pay a monthly exchange participant fee of one percent of average trailing month transaction amount”) and making an adjustment to a representation of exchange overhead value impact based on, for example, information captured from the metadata datasets 4206 and/or 4208.

As variously described herein, a representation of an item value may be multidimensional. Item value representation for translation from a first exchange may include value dimension associated with an intrinsic value of an item 4212. This may, for example, be an amount that a current owner of the item paid for the item (e.g., in an earlier transaction in the first or another exchange). An intrinsic amount for an item of currency (e.g., digital/crypto currency) may be a derived from a quantity of the item of currency and a currently discernable value of a unit of the corresponding currency. In example embodiments, an intrinsic value 4212 dimension of a representation of value of an item in a first exchange may be market-based, such as based on intrinsic value dimensions of comparable items. In this example, transaction history may play a role in determining an intrinsic value dimension of a representation of item value. Comparable item sales may generally suggest an intrinsic value dimension. A relevance and impact of an intrinsic value dimension of item value representation may, as described herein in examples and for embodiments depicted in the figures, be impacted by a range of factors, including, without limitation a quantity of the items available in the exchange (supply) and a degree of demand for the items. Similarly, an intrinsic value dimension of value representation may be influenced by similarity of an item to other items in the source exchange, the target exchange, or generally known by the value translation system 4210. Intrinsic differences in items (e.g., expected service life, damage history, specific features/upgrades, and the like) may determine, at least in part, how an intrinsic value dimension of an item in a first exchange is translated and impacts a representation of value of the item in a second exchange. The value translation system 4210 may process intrinsic value dimension 4212 information, along with intrinsic value-impacting metadata when producing a representation of value of an item including a target exchange intrinsic value dimension 4222.

In example embodiments, other value determining dimensions that may impact translation and representation of item value across exchanges may include, for a first exchange (e.g., exchange X 4202) a first exchange seller value dimension 4214, a first exchange buyer value dimension 4216, a first exchange platform value dimension 4218, and the like.

The value translation system 4210 may be operated, such as by an autonomous robotic process automation system 4209, to translate each dimension of value in a representation of value of an item in a first exchange into a corresponding dimension of value for item value representation in a second/target exchange. Translation of one or more first exchange seller value dimensions 4214 into corresponding target exchange seller value dimension(s) 4224 may include determination of first exchange seller value dimension 4214 factors and a contribution of at least a portion of such factors on a first exchange representation of item value. In a non-limiting example, a seller of an item in a first exchange for which item value is to be translated by the value translation system 4210, may have to pay a listing fee for the first exchange. This item of seller value dimension 4214 may not be present in the target exchange. Therefore translation of a first exchange seller value dimension 4214 to a corresponding second exchange seller value dimension 4224 may include elimination of a listing fee factor impact on the item value representation in the second exchange. In another example of translation of item value that may be impacted by seller value factors, currency preferences of the seller may be such a factor. In this example, a seller (e.g., the same seller/item owner in each of the first and target exchanges) may prefer to receive payments in cryptocurrency. The first exchange may not support cryptocurrency transactions, so the seller of the item in the first exchange must include in a seller value dimension transaction value in the form of a non-preferred currency. The implications of performing transactions in the first exchange may result in the seller setting a value (e.g., a higher sale price) that takes into consideration a measure of onus to the owner. Translation of item value may take into consideration this impact on a seller value dimension of item value. In this example, a robotic process automation-based autonomous item value translation may determine that a seller would adapt his/her perspective on item value based on the second/target exchange supporting a seller-preferred currency; in this example, a cryptocurrency.

Translating item value for representation from a first exchange value representation to a second exchange item value representation may include translating a first exchange buyer value dimension 4216 to determine a corresponding second/target exchange buyer value dimension 4226. While generally, buyers and sellers may express different values for an item, such as for the purposes of each of the buyer and seller maximizing, for example, value of a transaction, which may include a higher sale price from the seller's perspective and a lower price from the buyer's perspective. Further when translating a value of an item for representation in a second exchange, second exchange buyer value dimension factors may impact a buyer's perspective value differently than another buyer's perspective of item value in a first exchange. A range of buyer value dimension 4226 impacting factors are described herein. In example, a potential buyer in a first exchange may have ready access to multiples of an item in a first exchange. A potential buyer in a second exchange may have limited access to the item. In this simple example, a first exchange buyer value dimension 4216 may have a negligible impact on item value representation. However, a second exchange buyer value dimension 4226 may have a substantive impact on item value in the second exchange. The translation system 4210 may detect/determine these two different buyer value dimension factors and adjust a representation of value during translation accordingly. Other buyer value dimensions (first exchange 4214, second exchange 4224) dimensions may include tax differences, and the like.

Another candidate dimension of value that contributes to a representation of item value in a first exchange may include a first exchange value dimension 4218. Exchange value dimension 4218 may include exchange-based impacts on item value, such as support in operations of the first exchange for promoting, transacting, financing, and delivery of an item. If, for example, support for promoting and financing transactions for the item is available in a first exchange and is not available in a second exchange, translation of item value from the first exchange to the second exchange may be influenced by this difference in exchange value. In this example, a representation of value of an item in the first exchange may include a representation of the exchange support factors; however, a corresponding representation of item value in the second exchange may not. For autonomous value translation, such as by a robotic process automation system 4209, detecting and adjusting value of an item in a second exchange that does not include comparable exchange value 4228 may result in a representation of value that expresses these differences in exchange value.

In example embodiments, value translation, such as through a robotic process automation system 4209 operating a value translation system 4210 may rely on, among other things, artificial intelligence-based value translation algorithms 4220. These algorithms 4220 may be configured, adapted, and maintained through use of machine learning-based feedback, such as from a feedback system 4230. As an example, a translation algorithm that facilitates conversion of a plurality of dimensions of item value from a representation of item value in first exchange for generating a representation of value of the item in a second exchange may benefit from feedback, such as relevance of a result of translation of one or more of the value dimensions, such as intrinsic, seller, buyer, and exchange. A feedback system 4230 may gather information from a second exchange, such as information that facilitates validation of translation algorithms that validate translation actions, such as translating one or more aspects of intrinsic value. Techniques for gathering feedback may include capturing data from a plurality of sensors disposed logically and/or physically throughout aspects of a second exchange, such as sensors that detect bidding by buyers for an item for which value was translated. Feedback that suggests that, for example, buyers generally place bids that are consistent with a representation of value of the item, reinforces value translation algorithms 4220 used to generate translated value. Feedback from, for example, smart contract configured for automating transactions of items in a second exchange (e.g., terms associated with exchange fees) may validate one or more translation actions, such as translating a first exchange exchange-value 4218 to a second exchange exchange-value 4228. Disclosed herein are a range of feedback-based machine learning techniques that may be applied to the methods and systems of value translation of the embodiments of FIG. 41.

### Value Translation and Conditional External Factors

Referring to FIG. 42, embodiments are depicted of a set of robotic process automation services that are configured to automatically translate the value of an item represented in a first exchange into a value of the item for representation in a second exchange while taking into consideration external factors that may result in a translation of value that is conditional based on the external factors. For discussion of the embodiments of FIG. 42, a first exchange may include Exchange X 4302; a second/target exchange may include Exchange Y 4304. Value translation, including producing a conditional value based on external factors, may be performed by a value translation system 4310. The value translation system 4310 may access exchange X metadata 4306 that may include one or more of the factors described above, such as transaction fees, access to funding, meaning of terminology, historical treatment of some factors, supported currencies, and the like that are associated with item value representation associated with Exchange X 4302. The value translation system 4310 may access a comparable data store of exchange item value representation associated metadata 4308 for exchange Y 4304. The value translation system 4310 may, among other things, process the exchange metadata (e.g., X exchange metadata 4306 and/or Y exchange metadata 4308, or portions thereof) to develop an understanding of how X exchange item value representation compares and/or relates to Y exchange item value representation. In an example, the value translation system 4310 may determine from such processing that exchange overhead that may be represented in item values for exchange Y may be a multiple of exchange overhead for exchange X. Further exchange overhead may be influenced by external factors that may suggest translation of value may be conditional. This value translation-impacting determination may be based using a comparative process for overhead values stated for each exchange, (e.g., 1% for exchange X and 1.2% for exchange Y). Determining one or more relationships of exchange overhead to item value representation for translating value my include parsing descriptive information (e.g., Exchange X overhead description: “An exchange transaction fee of one percent of transaction amount is included in each transaction”; exchange Y overhead description: “Participants are required to pay a monthly exchange participant fee of one percent of average trailing month transaction amount”) and making an adjustment to a representation of exchange overhead value impact based on, for example information captured from the metadata datasets 4306 and/or 4308.

As variously described herein, a representation of an item value may be multidimensional. Further, external value factors 4332, such as factors outside of at least direct control of an exchange (and/or an operator or participant of an exchange) may influence one or more dimensions of item value. Item value representation for translation from a first exchange may include value dimension associated with an intrinsic value of an item 4312. This may, for example, be an amount that a current owner of the item paid for the item (e.g., in an earlier transaction in the first or another exchange). An intrinsic amount for an item of currency (e.g., digital/crypto currency) may be a derived from a quantity of the item of currency and a currently discernable value of a unit of the corresponding currency. In example embodiments, an intrinsic value 4312 dimension of a representation of value of an item in a first exchange may be based on one or more external factors, such as after-market trading activity (e.g., private sales) of the item, comparable items and the like. An external value factor 4332 that may impact intrinsic value differently for different exchanges may include weather-based differences between typical use environments of the exchanges. An item that has a high intrinsic value in an exchange that is experiencing winter conditions may have a low intrinsic value for an exchange experiencing mild weather.

A relevance and impact of an intrinsic value dimension of item value representation may be impacted by a range of external factors, including, without limitation a quantity of the items available to buyers in a jurisdiction of an exchange (supply) and a degree of demand for the items. Similarly, an intrinsic value dimension 4312 of value representation may be influenced by similarity of an item to other items in the source exchange, the target exchange, external to either or both exchanges, and otherwise generally known by the value translation system 4310. Intrinsic differences in items (e.g., expected service life, damage history, specific features/upgrades, after-sale offers that are outside of the exchange, and the like) may determine, at least in part, how an intrinsic value dimension of an item in a first exchange is translated and impacts a representation of value of the item in a second exchange. External value factors 4332, such as a likelihood of an environmental event/weather conditions and the like, particularly when those external factors differ among exchanges, may impact translation of an intrinsic dimension of value. The value translation system 4310 may process intrinsic value dimension 4312 information, along with intrinsic value-impacting metadata, and optionally with intrinsic value-impacting external value factors 4332 when producing a representation of value of an item including a target exchange intrinsic value dimension 4222.

In example embodiments, other value determining dimensions that may impact translation and representation of item value across exchanges may include, for a first exchange (e.g., exchange X 4302) a first exchange seller value dimension 4314, a first exchange buyer value dimension 4316, a first exchange platform value dimension 4318, and the like. Factors that may impact translation of one or more of the first exchange dimensions of value may include external value factors 4332 and/or results of processing the external factors 4332, such as with a conditional value processing system 4334.

The value translation system 4310 may be operated, such as by an autonomous robotic process automation system 4309, to translate each dimension of value in a representation of value of an item in a first exchange into a corresponding dimension of value for item value representation in a second/target exchange. Robotic process automation-based translation may also include generating a conditional value factor 4334 and applying that factor to the translation of one or more first exchange seller value dimensions 4314 into corresponding target exchange seller value dimension(s) 4324 may include determination of first exchange seller value dimension 4314 factors and a contribution of at least a portion of such factors on a first exchange representation of item value. In a non-limiting example, a seller of an item in a first exchange for which item value is to be translated by the value translation system 4310, may have to pay a listing fee to a listing service that is external to the first exchange. This external factor of seller value dimension 4324 may not be present in the target exchange. Therefore translation of a first exchange seller value dimension 4314 to a corresponding second exchange seller value dimension 4324 may include elimination of an external service listing fee factor impact on the item value representation in the second exchange.

Translating item value for representation from a first exchange value representation to a second exchange item value representation may include translating a first exchange buyer value dimension 4316 to determine a corresponding second/target exchange buyer value dimension 4326. Further when translating a value of an item for representation in a second exchange, second exchange buyer value dimension factors may impact a buyer's perspective value differently than another buyer's perspective of item value in a first exchange. A range of buyer value dimension 4326 impacting factors, at least some of which may be influenced by external value factors 4332 are described herein. In example, a quantity of items available to a potential buyer in a first exchange may be limited by external factors, such as rules that limit a number of items purchased based on an economic classification of the buyer (e.g., quantities allowed for foreign nationals may be limited). A potential buyer in a second exchange may not have such limits on access to the item. In this simple example, a first exchange buyer value dimension 4316 may have a conditional impact on item value representation (e.g., economic classification). However, a second exchange buyer value dimension 4326 may have a no such impact on item value in the second exchange. The translation system 4310 may detect/determine these two different buyer value dimension factors and adjust a representation of value during translation accordingly. Other external factor influenced buyer value dimensions (first exchange 4314, second exchange 4324) dimensions may include tax differences, and the like.

Another candidate dimension of value that contributes to a representation of item value in a first exchange may include a first exchange value dimension 4318. Exchange value dimension 4318 may include exchange-based impacts on item value, such as support in operations of the first exchange for promoting, transacting, financing, and delivery of an item. If, for example, support for promoting and financing transactions for the item is available in a first exchange and is not available in a second exchange, external value factors (e.g., third-parties providing these services) may influence translation of item value from the first exchange to the second exchange.

In example embodiments, value translation, such as through a robotic process automation system 4309 operating a value translation system 4310 may rely on, among other things, artificial intelligence-based value translation algorithms 4320. These algorithms 4320 may be configured, adapted, and maintained through use of machine learning-based feedback, such as from a feedback system 4330. These algorithms 4330 may further be adapted based on external value factors 4332 that may be structured as a conditional value impact 4334.

In an example of feedback of an impact of value 4330, a translation algorithm that facilitates conversion of a plurality of dimensions of item value from a representation of item value in first exchange for generating a representation of value of the item in a second exchange may benefit from feedback, such as relevance of a result of translation of one or more of the value dimensions, such as intrinsic, seller, buyer, and exchange. A feedback system 4330 may gather information from a second exchange, such as information that facilitates validation of translation algorithms that validate translation actions, such as translating one or more aspects of intrinsic value. Techniques for gathering feedback may include capturing data from a plurality of sensors disposed logically and/or physically throughout aspects of a second exchange, such as sensors that detect bidding by buyers for an item for which value was translated. Feedback that suggests that, for example, buyers generally place bids that are consistent with a representation of value of the item, reinforces value translation algorithms 4320 used to generate translated value. Feedback from, for example, smart contract configured for automating transactions of items in a second exchange (e.g., terms associated with exchange fees) may validate one or more translation actions, such as translating a first exchange exchange-value 4318 to a second exchange exchange-value 4328. Disclosed herein are a range of feedback-based machine learning techniques that may be applied to the methods and systems of value translation of the embodiments of FIG. 41.

In an example of external value factor 4332 impact on value translation, such as an impact of a conditional value factor 4334, an impending weather event in a target use market of items purchased in a second exchange may increase an impact of one or more of the dimensions of value. Further as a risk of the impending weather event increases or abates (which may be expressed as an external value factor conditional value 4334), a translation algorithm 4320 may be adapted accordingly.

Token Generation from Item Characteristics

In example embodiments, provided herein are computer-implemented methods and systems for automated orchestration of one or more marketplaces, such methods and systems are provided having a set of robotic process automation services that are configured to generate a token that represents an item in an exchange based on characteristics of the item determined from data from a different exchange. An item may contain and/or be associated with and/or be represented by a plurality of characteristics. Characteristics of an item that may be used to generate a token representing the item in an exchange may include a range of types of characteristics. Just a few examples include: physical characteristics (e.g., size, weight, volume, quantity, material, etc.), value-based characteristics (e.g., cost to purchase, cost to operate, tax value, energy value, collectability, etc.), accessibility characteristics (e.g., when an item is accessible, for now long, under what conditions can the item be accessed, and the like). In example embodiments, employing robotic process automation services to autonomously generate a token that represents an item in an exchange may benefit from an understanding of the various types of characteristics, their relative importance (e.g., weight) for a first/source exchange and for a second/target exchange.

Further, token generation may be performed for one or more purposes, at least a few of which may impact a token generation process, optionally including determining which characteristics of the item to rely upon when generating a token for representing the item. As an example, if an objective of token generation is to maximize transaction value of the item, characteristics that are associated with enhanced valuation of an item may be usefully processed to generate the token. If, for example, an object of generating a token is to achieve a very quick transaction (e.g., sale, rental, etc.) of the item, characteristics that engender such interest may be a focus of a representative token generation process. In yet another example, if an objective of generating a token that is representative of an item is to attract certain candidate buyers, corresponding characteristics may be a substantive part of representative token generation.

Referring to FIG. 43, embodiments of methods and systems for generating tokens that are representative of one or items based at least in part on characteristics of the items are depicted. More specifically, embodiments for methods and systems of robotic process automation-based token generation are depicted. In example embodiments, token generation for representation of an item in a second exchange may be based on characteristics of the item determined from data from a first (e.g., different) exchange. The embodiments depicted in FIG. 43 may include a first exchange X 4402 from which item characteristics 4406 are retrieved for token generation, e.g., via token generation system 4412 that may produce item token 4414 for exchange y 4404. At least one objective of such a system may be to configure a robotic process automation system to capture item characteristics 4406 of an item that is available in a first exchange; process those characteristics; and produce an item token 4414 that is useful in representing the item in a target exchange, such as exchange Y 4404.

In example embodiments, an item of a source exchange 4402 is identified, such as by designation through a user interface, automatically, semi-automatically, and the like. Generally independent of a means by which an item is identified for representative token generation, given that an item is identified, a robotic process automation process may automate collection of characteristics of the item 4406 from the first exchange 4402. Characteristics collection may be based on one or more mechanisms by which a first exchange makes information that is descriptive and/or contains characteristics of an item. In example, a first exchange 4402 may provide and/or make available a directory (e.g., list and the like) of items in the exchange. The list may include a set of characteristics for the item, such as identifying characteristics, physical characteristics, ownership characteristics, performance/service characteristics, pricing and sales terms characteristics, and the like. Therefore, in an example of representative item token generation, a method of token generation, optionally through operation of a robotic process automation system 4410, may retrieve item characteristics 4406 of an identified item (not shown) and deliver the same to a token generation system 4412 whereat one or more item representative tokens 4414 may be generated.

The token generation system 4412 may process one or more retrieved item characteristics (e.g., characteristics of an item that is represented in a first exchange 4402) for generating an item token 4414 along with characteristics rules 4408 of a target exchange (e.g., exchange Y 4404 in the embodiments of FIG. 43). Target exchanges may maintain the set of characteristics rules 4408 to facilitate, among other things, representing an item based on item characteristics, and optionally for use and/or understanding of item characteristics. The token generation system 4412 may query one or more control facilities, such as an exchange control tower of a target exchange to retrieve characteristics rules that are pertinent to token generation. In an example of characteristic rule querying, an item characteristic retrieved for an item for which a representative token is being generated may indicate a dimension of the item in imperial units. The token generation system 4412 may generate a query (e.g., a lookup type data structure) that indicates information about the characteristic, such as the type of characteristic, data of the instance of the type of characteristic, and the like. In this example the token generation system may present a query data structure that includes at least a type attribute (physical dimension), and optionally a value attribute (3.1), and a unit attribute (e.g., imperial inches). The token generation system 4412 may access a target exchange characteristics rules data structure 4408, such as by comparing one or more of the query data structure elements to entries in the rules data structure 4408. Alternatively, the query data structure may be presented to the exchange control tower or other exchange management facility whereat a search or other action is taken of a rules data structure to provide a corresponding characteristic rule for use in generating a representative token based at least in part on the specific item characteristic. Further in this example, a corresponding characteristics rule may indicate that for compliance with physical dimension characteristics of items in the target exchange, units for such values are to be metric. When this rule is applied, the token generation system 4412 may convert the item dimension of 3.1 inches to a corresponding quantity of metric dimension (e.g., 78.74 mm); thereby causing the physical dimension characteristic to be represented in and/or by the generated item token 4414 in metric units.

Another example of use of characteristics rules by a token generation system 4412 may include minimum quantity characteristics. An item characteristic may indicate that a minimum transaction quantity of the item in a transaction is based on item count (e.g., a single item). A characteristic rule may require that a minimum transaction quantity of an item in the target exchange be based on transaction amount. Therefore, based on item cost, when applying the minimum transaction quantity rule, a minimum item count for a transaction to be represented by the generated item token 4414 may be greater than a single item.

A generated item token 4414 that is representative of the item may be encoded with the item characteristics. Characteristics of an item that indicate physical aspects of the item may be encoded as displayable elements in the token (e.g., color, general shape, relative size, and the like). Characteristics that are time-related (e.g., expiration date, automatic renewal date, best-by date, offer validity timeframe, changes in characteristics over time, and the like) may be encoded as terms and/or conditions of a corresponding smart contract. Characteristics that are value related (e.g., purchase costs, operating costs, residual fees, return fees, finance fees, and the like) may be encoded in the token. In example embodiments, a generated item token 4414 may reference a companion set of item characteristics 4416 that are associated with token. The item characteristics 4406, processed and adjusted as needed based on exchange rules 4408 by the token generation system 4412 may be output to a characteristics data structure 4416 that is linked to a generated token 4414.

In example embodiments, the methods and systems of characteristics-based token generation may be performed by a robotic process automation service 4410 that may be trained on a set of token generation actions, such as actions taken by humans, the token generation system 4412 and the like. Robotic process automation services 4410 may facilitate autonomous generation of representative tokens based on item characteristics of an item of a source exchange for use in a target exchange. Robotic process automation services 4410, when combined with the token generation system 4412 capabilities and processing systems may automate conversion of a plurality of sets of item characteristics in a first exchange to item-representative tokens in a second exchange.

Token Generation from Item Token with Characteristic Harvesting Algorithm

Referring to FIG. 44, embodiments of methods and systems for generating tokens that are representative of one or items based at least in part on characteristics of the items are depicted. More specifically, embodiments for methods and systems of robotic process automation-based token generation are depicted. In example embodiments, token generation for representation of an item in a second exchange may be based on characteristics of the item determined from data extracted from a token (e.g., a digital representation) of the item from a first (e.g., different) exchange. The embodiments depicted in FIG. 44 may include a first exchange X 4502 that includes and/or makes use of item tokens 4506 from which item characteristics are determined for token generation, e.g., via token generation system 4512 that may produce a target exchange item token 4514 for exchange y 4504. At least one objective of such a system may be to configure a robotic process automation system to harvest item characteristics from a token 4506 of an item that is available in a first exchange; process those characteristics; and produce a target exchange item token 4514 (and optionally a companion set of item characteristics 4516) that is useful in representing the item in a target exchange, such as exchange Y 4504.

In example embodiments, an item of a source exchange 4502 is identified, such as by designation through a user interface, automatically, semi-automatically, and the like. Generally independent of a means by which an item is identified for representative token generation, given that an item is identified, a robotic process automation process may automate harvesting of characteristics of the item from an item token 4506 of the first exchange 4502. Characteristics harvesting may be based on one or more characteristics harvesting algorithms 4518 that may be used to process an item representative token 4506 of a first exchange to determine information that is descriptive and/or contains characteristics of an item. In an example, a first exchange 4502 may provide and/or make available a directory (e.g., list and the like) of items and corresponding item tokens 4506 in the exchange. The list may include and/or reference a set of characteristics represented by the item token 4506 for each item, such as identifying characteristics, physical characteristics, ownership characteristics, performance/service characteristics, pricing and sales terms characteristics, and the like. Therefore, in an example of representative item token generation, a token generation system 4512, optionally through operation of a robotic process automation system 4510, may process an item-representative token 4506 with characteristics harvesting algorithms 4518 to retrieve item characteristics of an identified item (not shown) and generate one or more target item representative tokens 4514 for a second/target exchange.

The characteristic harvesting algorithms 4518 may facilitate conversion of item-representative token content, optionally a digital representation of the item including characteristics of the item into item characteristics suitable for use by the token generation system 4512 to produce at least a corresponding target exchange item representative token. A digital representation of an item 4506 may contain and/or reference a wide range of aspects associated with an item of an exchange. Some of the aspects may characterize the item; some may characterize a context of the exchange that is pertinent to the item, others may be indicative of a seller, a broker, use and other conditions, and the like. The characteristics harvesting algorithms 4518 may facilitate parsing item token 4506 content to distinguish among the potentially many types of content, only some of which may be pertinent to target exchange item representative token generation. In example embodiments, digital representation of source exchange aspects in an item token 4506 may not be pertinent to generating a target exchange item-representative token 4514 and therefore may be effectively filtered by application of one or more of the characteristic harvesting algorithms 4518. The characteristics harvesting algorithms 4518 may reference a set of characteristics types that may be associated with different target exchanges. The token generation system 4512 may, through the algorithms, identify for retrieval and for processing a portion of the set of characteristics types that are associated with the target exchange (exchange Y 4504 in the embodiments of FIG. 44). In example embodiments, robotic process automation services 4510 may facilitate automated execution of this aspect of token generation for configuring an instance of the token generation system 4512 for generating a target exchange item-representative token for a target exchange 4504 from an item-representative token 4506 of a source exchange 4502.

The token generation system 4512 may process one or more harvested item characteristics (e.g., characteristics of an item retrieved from an item token 4506 of a first exchange 4502) for generating a target exchange item token 4514 along with characteristics rules 4508 of a target exchange (e.g., exchange Y 4504 in the embodiments of FIG. 44). Target exchanges may maintain the set of characteristics rules 4508 to facilitate, among other things, representing an item based on item characteristics, and optionally for use and/or understanding of item characteristics. The token generation system 4512 may query one or more control facilities, such as an exchange control tower of a target exchange to retrieve characteristics rules that are pertinent to token generation. In an example of characteristic rule querying, an item characteristic retrieved for an item for which a representative token is being generated may indicate a dimension of the item in imperial units. The token generation system 4512 may generate a query (e.g., a lookup type data structure) that indicates information about the characteristic, such as the type of characteristic, data of the instance of the type of characteristic, and the like. In this example the token generation system may present a query data structure that includes at least a type attribute (physical dimension), and optionally a value attribute (3.1), and a unit attribute (e.g., imperial inches). The token generation system 4512 may access a target exchange characteristics rules data structure 4508, such as by comparing one or more of the query data structure elements to entries in the rules data structure 4508. Alternatively, the query data structure may be presented to the exchange control tower or other exchange management facility whereat a search or other action is taken of a rules data structure to provide a corresponding characteristic rule for use in generating a representative token based at least in part on the specific item characteristic. Further in this example, a corresponding characteristics rule may indicate that for compliance with physical dimension characteristics of items in the target exchange, units for such values are to be metric. When this rule is applied, the token generation system 4512 may convert the item dimension of 3.1 inches to a corresponding quantity of metric dimension (e.g., 78.74 mm); thereby causing the physical dimension characteristic to be represented in and/or by the generated target exchange item token 4514 in metric units.

Another example of use of characteristics rules by a token generation system 4512 may include minimum quantity characteristics. An item characteristic harvested from or based on a first exchange item representative token 4506 may indicate that a minimum transaction quantity of the item in a transaction is based on item count (e.g., a single item). A minimum transaction quantity-associated characteristic rule for a target exchange may require that a minimum transaction quantity of an item in the target exchange be based on transaction amount. Therefore, taking into consideration item unit cost, when applying this example target exchange minimum transaction quantity rule, a minimum item count for a transaction to be represented by the generated target exchange item token 4514 may be greater than a single item.

A generated target exchange item token 4514 that is representative of the item may be encoded with the item characteristics. Characteristics of an item that indicate physical aspects of the item may be encoded as displayable elements in the token (e.g., color, general shape, relative size, and the like). Characteristics that are time-related (e.g., expiration date, automatic renewal date, best-by date, offer validity timeframe, changes in characteristics over time, and the like) may be encoded as terms and/or conditions of a corresponding smart contract. Characteristics that are value related (e.g., purchase costs, operating costs, residual fees, return fees, finance fees, and the like) may be encoded in the token. In example embodiments, a generated item token 4514 may reference a companion set of item characteristics 4516 that are associated with token. The item characteristics 4506, processed and adjusted as needed based on exchange rules 4508 by the token generation system 4512 may be output to a characteristics data structure 4516 that is linked to a generated token 4514.

In example embodiments, the methods and systems of FIG. 44 for characteristics harvesting and target exchange token generation may be performed by a robotic process automation service 4510 that may be trained on a set of token generation actions, such as actions taken by humans, the token generation system 4512 and the like. Robotic process automation services 4510 may facilitate autonomous generation of representative tokens based on item characteristics of an item of a source exchange for use in a target exchange. Robotic process automation services 4510, when combined with the token generation system 4512 capabilities and processing systems may automate conversion of a plurality of sets of item characteristics in a first exchange to item-representative tokens in a second exchange.

In example embodiments, the methods and systems for item characteristic harvesting and target exchange token (and optional smart contract) generation may include converting a token from a first exchange to a token for the target exchange. Such token conversion may include deriving item characteristics from the first exchange token, such as by use of item characteristic harvesting algorithms 4518 and the like and producing an item token for the item for a target exchange that is consistent with governing rules of the target exchange. A non-limiting governing rule of a target exchange may include use of an exchange-preferred currency, which may be different than a currency of the exchange from which the item characteristics in a corresponding token are harvested. An example of achieving compliance with target exchange governing rules may include conversion from the first exchange currency to the target exchange preferred currency. In another example of achieving compliance with currency-related target exchange governing rules, a rate of exchange, a process for currency exchange (e.g., conversion through an intermediate currency), and the like may be performed during token conversion.

Conversion to a target exchange token may include generating one or more smart contracts based on a combination of source exchange token characteristics (as may be harvested and/or derived as described herein), such as for presentation of the item in the second exchange.

Conversion to a target exchange token may include execution of a smart contract associated with at least one of the item, the source/first exchange, and the target exchange. Such a token conversion smart contract may be configured with terms that provide a degree of control on a token conversion process. An example token conversion smart contract term may be for facilitating harvesting of item characteristics from a source token, such as limiting access to item characteristics based on legal jurisdiction of on one or more of the source and target exchanges. In this example, information that may describe characteristics of an item in a first exchange may require export clearance before being presented in an exchange outside of a jurisdiction of the first exchange. A smart contract that may facilitate and/or control aspects of token item characteristic harvesting and/or conversion may dictate which information requires export clearance, and one or more ways by which such clearance is to be obtained. A smart contract may identify how such information is to be handled, processed, stored, transferred, and the like, including without limitation preventing access to the relevant characteristics information for services and the like that enable export of information, such as services that may facilitate conversion of item characteristics from a first jurisdiction to a second restricted jurisdiction, and the like.

Token Generation from Items and Smart Contract

Referring to FIG. 45, embodiments of methods and systems for generating tokens (and optional corresponding smart contracts) that are representative of one or items based at least in part on characteristics of the items and one or more corresponding smart contracts are depicted. More specifically, embodiments for methods and systems of robotic process automation-based token generation are depicted. In example embodiments, token (and optionally item smart contract) generation for representation of an item in a second exchange may be based on characteristics of the item determined from data extracted from an item 4605 and optionally from a smart contract 4506 of an item from a first (e.g., different) exchange. The embodiments depicted in FIG. 45 may include a first exchange X 4602 that includes and/or makes use of item 4605 and item smart contracts 4606 from which at least item characteristics are determined for token generation, e.g., via token generation system 4612 that may produce a target exchange item token 4614 and optional target exchange item smart contract 4616 for exchange y 4604. At least one objective of such a system may be to configure a robotic process automation system to harvest item characteristics from an item and contract terms from a smart contract for the item that is available in a first exchange; process those characteristics and terms; and produce a target exchange item token 4614 (and optionally a companion target exchange item smart contract 4616) that is useful in representing the item in a target exchange, such as exchange Y 4604.

In example embodiments, an item of a source exchange 4602 is identified, such as by designation through a user interface, automatically, semi-automatically, and the like. Generally independent of a means by which an item is identified for representative token generation, given that an item is identified, a robotic process automation process may automate collection of characteristics of the item from the item 4605 of the first exchange 4602. Further a smart contact 4606 associated with the item 4605 may be identified and processed (e.g., through a smart contract parsing system 4618) to produce one or more smart contract terms associated with the item 4605. The token generation system 4612 may process the item 4605 to determine information that is descriptive and/or contains characteristics to be used at least for generating a target exchange item-representative token 4614.

In an example, a first exchange 4602 may provide and/or make available a directory (e.g., list and the like) of items 4605 and corresponding smart contracts 4606 for items in the exchange. The list may include and/or reference a set of characteristics of the item 4605, such as identifying characteristics, physical characteristics, ownership characteristics, performance/service characteristics, pricing and sales terms characteristics, and the like. Therefore, in an example of representative item token generation, a token generation system 4612, optionally through operation of a robotic process automation system 4610, may process characteristics of an identified item 4605 and generate one or more target item representative tokens 4614 for a second/target exchange.

The smart contract parsing system 4618 may facilitate conversion of item-specific contract terms into a set of smart contract terms suitable for use by the token generation system 4612 to produce at least a corresponding target exchange item-specific smart contract 4616. An item smart contract 4606 may contain and/or reference a wide range of contract terms associated with an item of an exchange. Some of the terms may characterize the item; some may characterize a context of the exchange that is pertinent to the item, others may be indicative of seller terms, broker terms, use and other conditions, and the like. The smart contract parsing system 4618 may facilitate parsing a source smart contract 4606 content to distinguish among the potentially many types of content and/or terms, only some of which may be pertinent to target exchange item representative token and companion smart contract generation. In example embodiments, smart contract terms of a source exchange in an item smart contract 4606 may not be pertinent to generating a target exchange smart contract for the item and therefore may be effectively filtered by use of the smart contract parsing system 4618. The smart contract parsing system 4618 may reference a set of types of contract terms that may be associated with different target exchanges. The smart contract parsing system 4618 may identify for retrieval and for processing a portion of the set of contract term types that are associated with the target exchange (exchange Y 4604 in the embodiments of FIG. 45). In example embodiments, robotic process automation services 4610 may facilitate automated execution of this aspect of token and contract generation for configuring an instance of the token generation system 4612 for generating a target exchange item-representative token (and optional smart contract) for a target exchange 4604 from an item-associated smart contract 4606 of a source exchange 4602.

The token generation system 4612 may process one or more item characteristics (e.g., characteristics of an item retrieved from an item 4605 of a first exchange 4602) along with contract terms of the corresponding item smart contract 4606 for generating a target exchange item token 4614 and smart contract. This processing may further rely on characteristics rules 4608 of a target exchange (e.g., exchange Y 4604 in the embodiments of FIG. 45). Target exchanges may maintain the set of characteristics rules 4608 to facilitate, among other things, representing an item based on item characteristics, and optionally for use and/or understanding of item characteristics. The token generation system 4612 may query one or more control facilities, such as an exchange control tower of a target exchange to retrieve characteristics rules that are pertinent to token generation.

An example of use of characteristics rules by a token generation system 4612 may include minimum quantity characteristics. A smart contract term harvested from or based on a first exchange item smart contract 4606 may indicate that a minimum transaction quantity of the item in a transaction is based on item count (e.g., a single item). A minimum transaction quantity-associated characteristic rule for a target exchange may require that a minimum transaction quantity of an item in the target exchange be based on transaction amount. Therefore, taking into consideration item unit cost, when applying this example target exchange minimum transaction quantity rule, a contract term of target exchange item smart contract 4616 may indicate that a minimum item count for a transaction to be represented by the generated target exchange item token 4614 be based on transaction amount, which may be greater than a single item.

The token generation system 4612 may rely on (e.g., interact with) a smart contract engine 4620 when processing at least contract terms of the source item smart contract 4606. The smart contract engine 4620 may generate and/or validate (e.g., through simulation and the like) at terms for the target exchange smart contract 4616 that comply with smart contract best practices and with target exchange characteristics rules 4608. As an example, if physical units designated in a target exchange characteristics set of rules 4608 indicate such units are to be metric units, the smart contract engine 4620 may create terms and/or conditions associated with the target exchange generated item-representative token 4614 that are expressed in metric terms. The resulting smart contract 4616 may indicate that a deployment of the item must be on a surface that stably supports the weight of the item, which would require use of metric units (e.g., metric tons) as a criteria for meeting smart contract compliance of this item installation-related term. IN this way the target exchange smart contract 4616 term directly relates to a characteristic of the item (e.g., a metric weight of the item) included in the item-representative target exchange token 4614.

A generated target exchange item token 4614 that is representative of the item may be encoded with the item characteristics. Characteristics of an item that indicate physical aspects of the item may be encoded as displayable elements in the token (e.g., color, general shape, relative size, and the like). Characteristics that are time-related (e.g., expiration date, automatic renewal date, best-by date, offer validity timeframe, changes in characteristics over time, and the like) may be encoded as terms and/or conditions of a corresponding smart contract. Characteristics that are value related (e.g., purchase costs, operating costs, residual fees, return fees, finance fees, and the like) may be encoded in the token. In example embodiments, a generated item token 4614 may reference a companion smart contract 4616. The contract terms of the smart contract 4606, processed (e.g., by the smart contract parsing system 4618) and adjusted as needed based on exchange rules 4608 (e.g., by the smart contract engine 4620) may be output to a target exchange item-specific smart contract 4616 that is linked to a generated token 4614.

In example embodiments, the methods and systems of FIG. 45 for contract term harvesting and target exchange token (and optional smart contract) generation may be performed by a robotic process automation service 4610 that may be trained on a set of token and smart contract generation actions, such as actions taken by humans, the token generation system 4612, the smart contract engine 4620, the smart contract parsing system 4618, and the like. Robotic process automation services 4610 may facilitate autonomous generation of representative tokens based on item characteristics of an item of a source exchange for use in a target exchange. Robotic process automation services 4610, when combined with the token generation system 4612 capabilities and processing systems may automate generation of a plurality of target exchange item-representative tokens 4614 and target exchange item-specific smart contracts 4616.

### Rights Token Generation

Referring to FIG. 46, embodiments of methods and systems for generating rights tokens (and optional corresponding smart contracts) that are representative of a set of rights relating to an item based at least in part on one or more of a smart contract of an item, or a set of terms and conditions of the item are depicted.

In example embodiments, rights token generation system 3764 may receive item-related smart contract information (e.g., via a smart contract processing system 3758 and the like that may generate and/or provide a set of smart contract parameters) and/or item-related terms and conditions (e.g., via a terms and condition analysis system 3766 and the like that may generate and/or provide a set of item-related terms and conditions) and produce, among other things, an item rights token 3768 that may be based at least in part on a target exchange set of governing rules 3762.

In example embodiments, rights related to an item 3752 that may be encoded into a generated item rights token 3768 may include, without limitation ownership rights, transaction dispositive (e.g., last right of refusal) rights, item use rights, item naming rights, item commercialization rights and the like. Ownership rights may include rights provided to an owner(s) of the item (e.g., a party who owns at least a portion of the item). Ownership rights may include rights provided with the item (e.g., rights to adapt the item, rights to reproduce the item, rights to an easement such as access to a parking space, and the like). Item related rights that may be transaction dispositive may include rights to set a minimum sale price, rights to set restrictions on buyer financial risk, and the like. Item related use rights may include, without limitation, rights to use an item for a limited duration, during a specific time frame, rights to cause normal wear and tear on the item, jurisdictional restrictions of use, and the like. Item commercialization rights may include rights to rent, lease, or otherwise license access to, use of, and resale of the item, use of the item for promotional purposes, and the like. Item naming rights may include rights to determine, such as for publication, promotion, and identification purposes a name of the item (e.g., rights to make a sports arena/stadium for a duration of time, such as for a calendar year and the like.

The rights token generation system 3764 may rely on a smart contract processing system 3758 to parse, decode, process (e.g., execute), or otherwise identify rights granted through and/or controlled by the smart contract for parties related to the item, such as a buyer, seller, curator, and the like. As an example, an item smart contract 3754 may indicate that a party may sell his/her share of the item; however a process for selling called out by the smart contract may indicate that the owned portion shall first be offered to one or more of the other owners/partial owners, who may have a first right of refusal, and the like. The smart contract processing system 3758 may determine if an item is controlled by a smart contract and may automatically process the smart contract to identify rights associated therewith. The smart contract processing system 3758 may also determine if an item has a reporting relationship with the smart contract, such as if the item is required to report into the smart contract. In a non-limiting example the item may be an electronic item (and/or may be monitored by an electronic monitoring device) that may be required to report activity to a smart contract associated with monetization by an exchange in which it is listed, and the like.

In example embodiments, an item for which a rights token may be generated, such as item 3752, may be associated with (e.g., may include) a set of terms and/or conditions 3756 that may identify, influence, or otherwise impact generation of a rights token for the item. Although these terms and conditions 3756 may not include explicit terms and conditions for rights, they may indicate certain factors that may impact generating an item rights token 3768. In an example, a condition associated with the item 3752 may include limits on operating the item in a residential neighborhood after dark. Such a condition may be analyzed by the terms and conditions analysis system 3766 that may produce a set of data regarding this condition that the right token generation system 3764 may convert into a limit on a set of use rights, such as rights to use (e.g., operate) the item include only daytime use.

In example embodiments, the rights token generation system 3764 may consult a set of target exchange governing rules 3762 when generating an item rights token 3768 for the target exchange. Sample target exchange governing rules are now described; however a more detailed description of target exchange governing rules and their impact on rights token generation may be found in the description associated with FIG. 47. Governing rules of the exchange may include exchange-specific rules, such as exchange transaction timing (e.g., settlement dwell time and the like), record keeping (e.g., use of a distributed ledger), rules associated with a platform through which the target exchange operates, and the like. Other sample target exchange governing rules 3762 may include transaction-specific rules, such as exchange of physical items may provide rights to a smart contract of the target exchange to monitor conditions of sale of items transacted through the exchange. A target exchange governing rule that may relate to item rights token generation may include minimum use durations (e.g., a minimum calendar time must lapse before the item can be re-transacted). Commercialization rights may be impacted by a set of target exchange governing rules 3762, such as requiring that resale of the item occur through the target exchange unless a fee (e.g., buyer resale release fee) is paid to the exchange, and the like.

In example embodiments, other example target exchange governing rules 3762 may include transactor and/or transactor-type rules. As an example, a set of item rights for an item rights token 3768 may be impacted by a liquidity of a transactor, such as a buyer and/or seller in a transaction for an item. A target exchange may retain a degree of ownership rights when a liquidity of a buyer is below a threshold. In such a case a smart contract may optionally be configured to update the degree of exchange ownership throughout a probation period after completion of a transaction for the item by the buyer.

In example embodiments, the methods and systems of FIG. 46 for rights token (and optional smart contract) generation may be performed by a robotic process automation service 3760 that may be trained on a set of rights token generation actions, such as actions taken by humans, the rights token generation system 3764, the smart contract processing system 3758, the terms and conditions analysis system 3766, and the like. Robotic process automation services 3760 may facilitate autonomous generation of rights tokens based on rights of an item in a source exchange for use in a target exchange. Robotic process automation services 3760, when combined with the rights token generation system 3764 capabilities may automate generation of a plurality of item rights tokens 3768 based on item terms and conditions 3756, item smart contract 3754, and target exchange governing rules 3762.

Rights Token Generation with Target Exchange Rules Details

Referring to FIG. 47, embodiments of methods and systems for generating item rights tokens that are representative of a set of rights relating to an item based at least in part on one or more of a smart contract of an item, a set of terms and conditions of the item, and a multi-dimensional set of target exchange governing rules are depicted.

In example embodiments, rights token generation system 3864 may receive item-related smart contract information (e.g., via a smart contract processing system 3858 and the like that may generate and/or provide a set of smart contract parameters) and/or item-related terms and conditions (e.g., via a terms and condition analysis system 3866 and the like that may generate and/or provide a set of item-related terms and conditions) and produce, among other things, an item rights token 3868 that may be based at least in part on a target exchange set of multi-dimensional governing rules 3862.

In example embodiments, rights related to an item 3852 that may be encoded into a generated item rights token 3868 may include, without limitation ownership rights, transaction dispositive (e.g., last right of refusal) rights, item use rights, item naming rights, item commercialization rights and the like. Ownership rights may include rights provided to an owner(s) of the item (e.g., a party who owns at least a portion of the item). Ownership rights may include rights provided with the item (e.g., rights to adapt the item, rights to reproduce the item, rights to an easement such as access to a parking space, and the like). Item related rights that may be transaction dispositive may include rights to set a minimum sale price, rights to set restrictions on buyer financial risk, and the like. Item related use rights may include, without limitation, rights to use an item for a limited duration, during a specific time frame, rights to cause normal wear and tear on the item, jurisdictional restrictions of use, and the like. Item commercialization rights may include rights to rent, lease, or otherwise license access to, use of, and resale of the item, use of the item for promotional purposes, and the like. Item naming rights may include rights to determine, such as for publication, promotion, and identification purposes a name of the item (e.g., rights to make a sports arena/stadium for a duration of time, such as for a calendar year and the like.

The rights token generation system 3864 may rely on a smart contract processing system 3858 to parse, decode, process (e.g., execute), or otherwise identify rights granted through and/or controlled by the smart contract for parties related to the item, such as a buyer, seller, curator, and the like. As an example, an item smart contract 3854 may indicate that a party may sell his/her share of the item; however a process for selling called out by the smart contract may indicate that the owned portion shall first be offered to one or more of the other owners/partial owners, who may have a first right of refusal, and the like. The smart contract processing system 3858 may determine if an item is controlled by a smart contract and may automatically process the smart contract to identify rights associated therewith. The smart contract processing system 3858 may also determine if an item has a reporting relationship with the smart contract, such as if the item is required to report into the smart contract. In a non-limiting example the item may be an electronic item (and/or may be monitored by an electronic monitoring device) that may be required to report activity to a smart contract associated with monetization by an exchange in which it is listed, and the like.

In example embodiments, an item for which a rights token may be generated, such as item 3852, may be associated with (e.g., may include) a set of terms and/or conditions 3856 that may identify, influence, or otherwise impact generation of a rights token for the item. Although these terms and conditions 3856 may not include explicit terms and conditions for rights, they may indicate certain factors that may impact generating an item rights token 3868. In an example, a condition associated with the item 3852 may include limits on operating the item in a residential neighborhood after dark. Such a condition may be analyzed by the terms and conditions analysis system 3866 that may produce a set of data regarding this condition that the right token generation system 3864 may convert into a limit on a set of use rights, such as rights to use (e.g., operate) the item include only daytime use.

In example embodiments, the rights token generation system 3864 may consult a multi-dimensional set of target exchange governing rules 3862 when generating an item rights token 3868 for use in a target exchange. Target exchange governing rules 3862 may include a plurality of dimensions and/or type of governing rules including, without limitation, jurisdiction rules 3870, item industry rights standards 3872, rights token templates 3874 and the like.

Jurisdiction governing rules 3870 may impact right token generation system 3864, such as by setting constraints on one or more rights associated with the item. As an example, an item may be permitted to be owned and transacted by a non-citizen in a first jurisdiction; however, the item may not be permitted to be owned by a non-citizen in a jurisdiction of a target exchange in which the item rights token 3868 is to be used. For a non-citizen to acquire the item in a jurisdiction of the target exchange, ownership rights may have to be shared with a legal entity formed in the target exchange jurisdiction, and the like. Jurisdiction rules 3870 that may be consulted by the rights token generation system 3864 may include age limits for items that may be different than those found in a set of item terms and conditions 3856, for example. The rights token generation system 3864 may receive item terms and conditions 3856 that may indicate only users above age 18 can operate the item. However, when this age-related condition is evaluated against a target jurisdiction age rule for the item, the resulting item rights token 3868 may limit operation to users above age 20 or may permit operation by users as young as 16 years.

Another type of target exchange governing rule 3862 may include item industry rights standards 3872 that may include a set of standards developed for an industry of the item for guiding selection and/or generation of item rights. In an example of a livestock industry, a set of industry rights standards 3872 may include guidelines for rights of third-parties to perform inspection, use rights for different classes of livestock (e.g., goats versus Clydesdales), and the like. The industry rights standards 3872 may be relied up by the rights token generation system 3864 to facilitate adapting rights detected through smart contract processing 3858 and/or through terms and condition analysis 3866. If a right determined by the smart contract processing system 3858 presents a conflict with an industry rights standard 3872, the rights token generation system 3864 may adapt the incoming smart-contract determined right to be compliant with the industry standard rights 3872.

Another type or dimension of target exchange governing rules 3862 may include rights token templates 3874. A target exchange may publish a set of rights token templates for ensuring compliance with any applicable governing rules, such as jurisdiction rules 3870, industry rights standards 3872, and the like. A set of rights templates 3874 may include exchange-based rights templates that may include a minimum set of rights for items transacted in the exchange. A set of rights templates 3874 may include templates and/or configure one or more templates to include industry group rights standards, regulatory-based rights, and the like. In example embodiments, exchanges may establish rights token templates to facilitate differentiation from other exchanges, such as to provide a way for item owners to identify benefits of engaging with one exchange or another, for example.

In example embodiments, the methods and systems of FIG. 47 for rights token (and optional smart contract) generation may be performed by a robotic process automation service 3860 that may be trained on a set of rights token generation actions, such as actions taken by humans, the rights token generation system 3864, the smart contract processing system 3858, the terms and conditions analysis system 3866, and the like. Robotic process automation services 3860 may facilitate autonomous generation of rights tokens based on rights of an item in a source exchange for use in a target exchange. Robotic process automation services 3860, when combined with the rights token generation system 3864 capabilities may automate generation of a plurality of item rights tokens 3868 based on item terms and conditions 3856, item smart contract 3854, and target exchange governing rules 3862.

Rights Token Generation with Rights Conformance Evaluation

Referring to FIG. 48, embodiments of methods and systems for generating item rights tokens that are representative of a set of rights relating to an item based at least in part on one or more of a smart contract of an item, a set of terms and conditions of the item, and that are compliant with one or more target exchange governing rules are depicted.

In example embodiments, rights conformance evaluation system 3970 may receive item-related smart contract information (e.g., via a smart contract processing system 3958 and the like that may generate and/or provide a set of smart contract parameters) and/or item-related terms and conditions (e.g., via a terms and condition analysis system 3966 and the like that may generate and/or provide a set of item-related terms and conditions) and produce, among other things, a set of conforming rights 3974 and optionally a set of non-conforming rights 3972 based at least in part on a target exchange set of governing rules 3962. In example embodiments, the rights conformance evaluation system 3970 may determine, for one or more rights received if it conflicts with a corresponding target exchange governing rule 3962. The rights conformance evaluation system 3970 may determine that a right received is a non-confirming right 3972, a conforming right 3974, or that conformance is not dispositive through the evaluation. In example embodiments, rights that determined to be other than non-conforming may be deemed to be conforming.

The rights conformance evaluation system 3970 may rely on a smart contract processing system 3958 to parse, decode, process (e.g., execute), or otherwise identify rights granted through and/or controlled by the smart contract for parties related to the item, such as a buyer, seller, curator, and the like. As an example, an item smart contract 3954 may indicate that a party may sell his/her share of the item; however a process for selling called out by the smart contract may indicate that the owned portion shall first be offered to one or more of the other owners/partial owners, who may have a first right of refusal, and the like. The smart contract processing system 3958 may determine if an item is controlled by a smart contract and may automatically process the smart contract to identify rights associated therewith. The smart contract processing system 3958 may also determine if an item has a reporting relationship with the smart contract, such as if the item is required to report into the smart contract. In a non-limiting example the item may be an electronic item (and/or may be monitored by an electronic monitoring device) that may be required to report activity to a smart contract associated with monetization by an exchange in which it is listed, and the like. Item smart contract-derived rights may establish ownership rights that may conflict with target exchange governing rules 3962. An example ownership right conflict may include a smart contract assigning rights to revenues resulting from the use of the item to a third party, whereas the target exchange governing rules 3962 require such rights to revenues be determined by the acquiring owner of the item.

In example embodiments, an item for which a rights token may be generated, such as item 3952, may be associated with (e.g., may include) a set of terms and/or conditions 3956 that may identify, influence, or otherwise impact generation of a rights token for the item. Although these terms and conditions 3956 may not include explicit terms and conditions for rights, they may indicate certain factors that may impact generating an item rights token 3968. In an example, a condition associated with the item 3952 may include limits on operating the item in a residential neighborhood after dark. Such a condition may be analyzed by the terms and conditions analysis system 3966 that may produce a set of data regarding this condition that the rights conformance evaluation system 3970 may evaluate against a corresponding target exchange governing rule 3962. If this set of data is indicative of a conforming right 3974, the right token generation system 3964 may convert it into a limit on a set of use rights, such as rights to use (e.g., operate) the item include only daytime use.

The rights conformance evaluation system 3970 may rely on an item terms and condition processing system 3966 to parse, decode, analyze, or otherwise identify rights associated with the item for parties related to the item, such as a buyer, seller, curator, and the like. An example of conflicting rights determined from analysis of item terms and conditions 3956 may include a right to own the item without formal registration of the item with a regulatory party (e.g., a firearm) that may conflict with a set of target exchange governing rules 3962 that require registration. The rights conformance evaluation system 3970 may flag this item right as a non-conforming right 3972.

In example embodiments, rights related to an item 3952 that are deemed to be conforming rights 3974 may be encoded into a generated item rights token 3968 and may include, without limitation ownership rights, transaction dispositive (e.g., last right of refusal) rights, item use rights, item naming rights, item commercialization rights and the like. Ownership rights may include rights provided to an owner(s) of the item (e.g., a party who owns at least a portion of the item). Ownership rights may include rights provided with the item (e.g., rights to adapt the item, rights to reproduce the item, rights to an easement such as access to a parking space, and the like). Item related rights that may be transaction dispositive may include rights to set a minimum sale price, rights to set restrictions on buyer financial risk, and the like. Item related use rights may include, without limitation, rights to use an item for a limited duration, during a specific time frame, rights to cause normal wear and tear on the item, jurisdictional restrictions of use, and the like. Item commercialization rights may include rights to rent, lease, or otherwise license access to, use of, and resale of the item, use of the item for promotional purposes, and the like. Item naming rights may include rights to determine, such as for publication, promotion, and identification purposes a name of the item (e.g., rights to make a sports arena/stadium for a duration of time, such as for a calendar year and the like.

In example embodiments, the methods and systems of FIG. 48 for rights conformance evaluation may be performed by a robotic process automation service 3960 that may be trained on a set of rights conformance evaluation actions, such as actions taken by humans, the rights conformance evaluation system 3970, the smart contract processing system 3958, the terms and conditions analysis system 3966, and the like. Robotic process automation services 3960 may facilitate autonomous evaluation of rights conformance and generation of rights tokens based on rights of an item in a source exchange for use in a target exchange. Robotic process automation services 3960, when combined with the rights conformance evaluation system 3970 and rights token generation system 3964 capabilities may automate rights conformance evaluation and rights token generation based on item terms and conditions 3956, item smart contract 3954, and target exchange governing rules 3962.

### Rights Token Generation and Adaptable Rights Tokens

Referring to FIG. 49, embodiments of methods and systems for generating adaptable rights tokens that are representative of a set of rights relating to an item based at least in part on one or more of a smart contract of an item, a set of terms and conditions of the item, target exchange governance rules, and adaptation factors are depicted.

In example embodiments, adaptable rights token generation system 4064 may receive item-related smart contract information (e.g., via a smart contract processing system 4058 and the like that may generate and/or provide a set of smart contract parameters) and/or item-related terms and conditions (e.g., via a terms and condition analysis system 4066 and the like that may generate and/or provide a set of item-related terms and conditions) and produce, among other things, an adaptable item rights token 4068 that may be based at least in part on a target exchange set of governing rules 4062.

In example embodiments, rights related to an item 4052 that may be encoded into a generated adaptable item rights token 4068 may include, without limitation ownership rights, transaction dispositive (e.g., last right of refusal) rights, item use rights, item naming rights, item commercialization rights and the like. Ownership rights may include rights provided to an owner(s) of the item (e.g., a party who owns at least a portion of the item). Ownership rights may include rights provided with the item (e.g., rights to adapt the item, rights to reproduce the item, rights to an easement such as access to a parking space, and the like). Item related rights that may be transaction dispositive may include rights to set a minimum sale price, rights to set restrictions on buyer financial risk, and the like. Item related use rights may include, without limitation, rights to use an item for a limited duration, during a specific time frame, rights to cause normal wear and tear on the item, jurisdictional restrictions of use, and the like. Item commercialization rights may include rights to rent, lease, or otherwise license access to, use of, and resale of the item, use of the item for promotional purposes, and the like. Item naming rights may include rights to determine, such as for publication, promotion, and identification purposes a name of the item (e.g., rights to make a sports arena/stadium for a duration of time, such as for a calendar year and the like.

The adaptable rights token generation system 4064 may rely on a smart contract processing system 4058 to parse, decode, process (e.g., execute), or otherwise identify rights granted through and/or controlled by the smart contract for parties related to the item, such as a buyer, seller, curator, and the like. As an example, an item smart contract 4054 may indicate that a party may sell his/her share of the item; however a process for selling called out by the smart contract may indicate that the owned portion shall first be offered to one or more of the other owners/partial owners, who may have a first right of refusal, and the like. The smart contract processing system 4058 may determine if an item is controlled by a smart contract and may automatically process the smart contract to identify rights associated therewith. The smart contract processing system 4058 may also determine if an item has a reporting relationship with the smart contract, such as if the item is required to report into the smart contract. In a non-limiting example the item may be an electronic item (and/or may be monitored by an electronic monitoring device) that may be required to report activity to a smart contract associated with monetization by an exchange in which it is listed, and the like.

In example embodiments, an item for which an adaptable rights token may be generated, such as item 4052, may be associated with (e.g., may include) a set of terms and/or conditions 4056 that may identify, influence, or otherwise impact generation of an adaptable rights token for the item. Although these terms and conditions 4056 may not include explicit terms and conditions for rights, they may indicate certain factors that may impact generating an adaptable item rights token 4068. In an example, a condition associated with the item 4052 may include limits on operating the item in a residential neighborhood after dark. Such a condition may be analyzed by the terms and conditions analysis system 4066 that may produce a set of data regarding this condition that the adaptable right token generation system 4064 may convert into a limit on a set of use rights, such as rights to use (e.g., operate) the item include only daytime use.

In example embodiments, the adaptable rights token generation system 4064 may consult a set of target exchange governing rules 4062 when generating an adaptable item rights token 4068 for the target exchange. Sample target exchange governing rules may include exchange-specific rules, such as exchange transaction timing (e.g., settlement dwell time and the like), record keeping (e.g., use of a distributed ledger), rules associated with a platform through which the target exchange operates, and the like. Other sample target exchange governing rules 3762 may include transaction-specific rules, such as exchange of physical items may provide rights to a smart contract of the target exchange to monitor conditions of sale of items transacted through the exchange. A target exchange governing rule that may relate to adaptable item rights token generation may include minimum use durations (e.g., a minimum calendar time must lapse before the item can be re-transacted). Commercialization rights may be impacted by a set of target exchange governing rules 4062, such as requiring that resale of the item occur through the target exchange unless a fee (e.g., buyer resale release fee) is paid to the exchange, and the like.

In example embodiments, other example target exchange governing rules 4062 may include transactor and/or transactor-type rules. As an example, a set of item rights for an adaptable item rights token 4068 may be impacted by a liquidity of a transactor, such as a buyer and/or seller in a transaction for an item. A target exchange may retain a degree of ownership rights when a liquidity of a buyer is below a threshold. In such a case a smart contract may optionally be configured to update the degree of exchange ownership throughout a probation period after completion of a transaction for the item by the buyer.

In example embodiments, adaptation of an adaptable item rights token 4068 may be based on a set of target exchange adaptation rules 4072, data associated with a transactor participant accessing the adaptable rights token 4068 and the like. A rights token adaptation system 4070 may, responsive to a request by an exchange participant (e.g., a transactor) 4076, adapt one or more aspects of the adaptable rights token 4068 to produce at least one transactor-specific item rights token 4074. The set of target exchange adaptation rules 4072 may include rules that define adaptation limits and criteria for certain rights, such as ownership rights, resale rights, use rights, and the like. An example target exchange adaptation rule 4072 may include constraints on how a right to use an item (e.g., a facility) may be adapted based on aspects of the transactor/buyer of the item. A right to use provided in an adaptable rights token for the item may be adapted based on an entity type of the transactor. Use rights for a non-profit type entity transactor may be adapted based on regulations for use of a facility by a non-profit entity. The rights token adaptation system 4070 may capture a request 4078 for the adaptable rights token 4068 corresponding to the facility from a non-profit exchange transactor 4076. Based on rules for facility use by a non-profit entity that may be provided by the target exchange adaptation rules data set 4072, the rights token adaptation system 4070 may generate a non-profit transactor-specific rights token 4074.

An adaptable item rights token generation and use system as depicted in FIG. 49 may facilitate per-use rights adaptation to suit a range of target exchange-specific rights constraints, participant-specific rights, and the like. In example embodiments, per-use rights adaptation of an adaptable item rights token 4068 may include generating a plurality of differentiated rights tokens for a plurality of differentiated transactors from a common set of adaptable item rights as may be captured by an adaptable item rights token 4068. Such per-use adaptation may also facilitate modeling of transactor-specific rights for items in different target exchanges. Application (e.g., in an off-line/sandbox/emulation mode) of a candidate set of exchange adaptation rules 4072 for a candidate target exchange to transactor-specific request data by the rights token adaptation system 4070 may facilitate predicting a set of data descriptive of a corresponding transactor-specific rights token 4074. Through use of a robotic process automation system 4060, a plurality of such transactor-specific rights token data sets may be generated and optionally presented to a transactor for evaluating which of a plurality of target exchanges provide the transactor with rights that align with, for example, a set of business goals of the transactor.

In example embodiments, the methods and systems of FIG. 49 for adaptable rights token generation may be performed by a robotic process automation service 4060 that may be trained on a set of adaptable rights token generation actions, such as actions taken by humans, the adaptable rights token generation system 4064, the smart contract processing system 4058, the terms and conditions analysis system 4066, a rights token adaptation system 4070, and the like. Robotic process automation services 4060 may facilitate autonomous generation of adaptable rights tokens based on rights of an item in a source exchange for use in a target exchange. Robotic process automation services 4060, when combined with the adaptable rights token generation system 4064 capabilities may automate generation of a plurality of adaptable item rights tokens 4068 based on item terms and conditions 4056, item smart contract 4054, and target exchange governing rules 4062, and the like.

Automated Orchestration of Exchanges with Cross-Exchange Action Responsiveness

In embodiments, provided herein are computer-implemented methods and systems for automated orchestration of one or more marketplaces. Automated orchestration may include cross-exchange workflow initiation associated with value normalization, value translation, item token generation, rights token generation and the like. In an example, such methods and systems may have a set of robotic process automation services that are configured to orchestrate a set of transaction workflows in each of a plurality of exchanges, such that initiation of a set of actions in one exchange automatically results in the triggering of a set of actions in at least one other exchange. In example embodiments, orchestration of the set of transaction workflows in each of the plurality of exchanges may initiate a set of actions in the set of transaction workflows that causes and/or contributes to initiation of one of the set of workflows in one exchange automatically results in the triggering of a set of corresponding/coordinating/item-centric actions that result in activating at least one of a corresponding set of workflows in the other exchange.

Referring to FIG. 50, a set of robotic process automation services 4160 may be applied to sets of workflows for a plurality of exchanges, such as exchange X 4152, exchange Y 4154, and exchange Z 4156. The set of robotic process automation services 4160 may facilitate automating one or more workflows 4158 of the exchanges.

Actions of a first exchange, such as actions 4162 of exchange X 4152 may include a first action XA1 4164. The first action 4164 may be selected from a set of actions 4166 including, without limitation normalization of item values within the first exchange, translation of value of an item from/to the first exchange to/from a second exchange, generation of an item token, generation of a rights token, and other actions. Initiation of the first action 4164 may trigger, cause, or contribute to initiation of at least one action in the second exchange. In example embodiments, initiation of the first action 4164 in exchange X 4152 may trigger activation of a set of actions 4168 in exchange Y 4154. The set of actions 4168 in exchange Y 4154 may include an action of a workflow of exchange Y, such as workflow Y WF 1 and/or workflow Y WF 2. The set of actions 4168 in exchange Y 4154 may include an action selected from a list of actions including value normalization, value translation, item token generation, rights token generation, and other actions.

Further, initiation of action XA1 4164 (a first action) in exchange X 4152 (a first exchange) may trigger initiation of action ZAn 4170 (a third action) in exchange Z 4156 (a third exchange). In this example, the first action (an action to normalize a value of an item) in the first exchange, may trigger activation of a value translation action (third action) in the third exchange.

In embodiments, methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to orchestrate a set of transaction workflows in each of a plurality of exchanges, such that initiation of a set of actions in the set of transaction workflows that causes/contributes to initiation of one of the set of workflows in one exchange automatically results in the triggering of a set of corresponding/coordinating/item-centric actions that result in activating at least one of a corresponding set of workflows in at least one other exchange.

In embodiments, methods and systems are provided having a set of robotic process automation services that are configured to automatically translate the value of an item represented in a first exchange into a value of the item for representation in a second exchange and having a set of robotic process automation services that are configured to orchestrate a set of transaction workflows in each of a plurality of exchanges, such that initiation of a set of actions in the set of transaction workflows that causes/contributes to initiation of one of the set of workflows in one exchange automatically results in the triggering of a set of corresponding/coordinating/item-centric actions that result in activating at least one of a corresponding set of workflows in at least one other exchange.

In embodiments, methods and systems are provided having a set of robotic process automation services that are configured to generate token that represents an item in an exchange based on characteristics of the item determined from data from a different exchange and having a set of robotic process automation services that are configured to orchestrate a set of transaction workflows in each of a plurality of exchanges, such that initiation of a set of actions in the set of transaction workflows that causes/contributes to initiation of one of the set of workflows in one exchange automatically results in the triggering of a set of corresponding/coordinating/item-centric actions that result in activating at least one of a corresponding set of workflows in at least one other exchange.

In embodiments, methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of robotic process automation services that are configured to orchestrate a set of transaction workflows in each of a plurality of exchanges, such that initiation of a set of actions in the set of transaction workflows that causes/contributes to initiation of one of the set of workflows in one exchange automatically results in the triggering of a set of corresponding/coordinating/item-centric actions that result in activating at least one of a corresponding set of workflows in at least one other exchange.

In example embodiments, the methods and systems of FIG. 50 for automatic triggering of actions across exchanges may be performed by a robotic process automation service 4160 that may be trained on a set of cross exchange workflow triggering actions, such as actions taken by humans, a cross-exchange action triggering facility, and the like. Robotic process automation services 4160 may facilitate autonomous configuration of links among transaction workflows, workflow actions, and exchange actions that enable actions in a first exchange automatically triggering actions in a second exchange. Robotic process automation services 4160 may facilitate automatically triggering one or more actions in one or more workflows for one or more exchanges for a set of transaction workflows across a plurality of exchanges.

Exchange actions in a first exchange may initiate workflows and/or initiate exchange actions in a second exchange

Referring to FIG. 51, a set of robotic process automation services may be configured to orchestrate a set of transaction workflows in each of a plurality of exchanges, such that initiation of a set of actions in a first exchange that causes initiation of a first transaction workflow of the set of transaction workflows of the first exchange may automatically result in the triggering of initiation of a set of corresponding actions in at least one other exchange, wherein the set of corresponding actions in the at least one other exchange cause initiation of a second transaction workflow of the set of transaction workflows of the at least one other exchange.

In example embodiments, a robotic process automation service 4260 may be configured to orchestrate a set of transaction workflows 4258 in each of a plurality of exchanges, such as exchange X 4252, exchange Y 4254, and exchange Z 4256. The set of transaction workflows 4258 may include one or more workflows of exchange X 4252, such as X WF 1 and X WF 2 as depicted in FIG. 51. The set of transaction workflows 4258 may include workflows in exchange Y 4254 (workflows Y WF 1 and Y WF 2), and may include workflows in exchange Z 4256 (workflows Y WF 1 and Y WF 2).

Exchange X 4252 may also include a set of actions 4262, such as action XA1 4264 that may trigger workflow X WF 1 in the set of transaction workflows 4258. The set of actions 4262 may also include action XA11 that may automatically trigger a corresponding action YA1 in a set of actions of exchange Y 4254. Action YA1 may initiate, within exchange Y a workflow 4268 in the set of transaction workflows 4258. Further Exchange X 4252 may include a third action XA12 in the set of actions 4262 that may automatically trigger an action ZAn 4270 in exchange X 4256, wherein action ZAn 4270 may be outside of the set of transaction workflows 4258.

The set of transaction workflows 4258 may include a plurality of workflows for achieving cross-exchange item handling as described herein, that may be selected form a set of workflows 4266 including without limitation one or more of an item value normalization workflow, an item value translation workflow, an item token generation workflow, a rights token generation workflow, and the like.

In example embodiments, the methods and systems of FIG. 51 for automatic triggering of actions across exchanges may be performed by a robotic process automation service 4260 that may be trained on a set of cross exchange workflow triggering actions, such as actions taken by humans, a cross-exchange action triggering facility, and the like. Robotic process automation services 4260 may facilitate autonomous configuration of links among transaction workflows, workflow actions, and exchange actions that enable actions in a first exchange automatically triggering actions in a second exchange. Robotic process automation services 4260 may facilitate automatically triggering one or more actions in one or more workflows for one or more exchanges for a set of transaction workflows across a plurality of exchanges.

Workflow Actions in a First Exchange May Initiate Workflows and/or Workflow Actions in a Second Exchange

Referring to FIG. 52, use of robotic process automation 4360 for operation of a plurality of workflows 4358 across a plurality of exchanges with triggered cross-exchange workflow initiation is depicted. A set of robotic process automation services may be configured to orchestrate a set of transaction workflows in each of a plurality of exchanges, such that initiation of a set of actions in the set of transaction workflows in a first exchange automatically results in the triggering of a set of one or more corresponding actions in a workflow of the set of workflows in at least one other exchange. A set of robotic process automation services may be configured to orchestrate a set of transaction workflows in each of a plurality of exchanges, such that initiation of an action in a workflow of the set of transaction workflows of a first exchange automatically results in triggering a corresponding action in a workflow of the set of transaction workflows of a second exchange. In example embodiments, triggering the corresponding action in a workflow of the set of transaction workflows of the second exchange automatically results in triggering a corresponding action in a workflow of the set of workflows of a third exchange. In example embodiments, the action of the first exchange is a selected from a set of actions comprising a value normalizing action, a value translation action, an item token generation action, and a rights token generation action. In example embodiments, the automatically triggered action of the second exchange is a selected from a set of actions comprising a value normalizing action, a value translation action, an item token generation action, and a rights token generation action. In example embodiments, the automatically triggered action of the third exchange is a selected from a set of actions comprising a value normalizing action, a value translation action, an item token generation action, and a rights token generation action.

In example embodiments, initiation of a set of actions 4364 from a set of transaction workflows 4362 of a first exchange 4352 may automatically result in triggering one or more workflows 4368 of a set of workflows in a second exchange 4354. The set of workflows in the second exchange may include workflows with actions that correspond with the set of actions 4364. The set of workflows in the second exchange may include workflows with actions that coordinate/compliment the set of actions 4364. Further the set of workflows in the second exchange may include workflows with item-centric actions for an item associated with the set of transaction workflows 4362.

Further, initiation of the set of actions 4364 from the set of transaction workflows 4362 of the first exchange 4352 may automatically result in triggering one or more workflow actions 4370 of a third exchange 4356. Workflow robotic process automation may facilitate automated execution of workflows and/or workflow actions across a plurality of exchanges, including cascading actions across the plurality of exchanges. In the example of FIG. 52, a first workflow X WF 2 4366 of a first exchange X 4352 may include a workflow action, such as a value normalization action as described herein. Activation of the value normalization action in the first exchange 4352 may trigger a corresponding workflow action, such as a value normalization action in a second workflow Y WF 2 of a second exchange Y 4354. This triggered corresponding value normalization action may further trigger activation of an item token generation action in a third workflow Z WF 2 of a third exchange Z 4356. In example embodiments, each of the cascaded actions may be performed for a common item. In this example, a value normalization action of a first item in exchange X may trigger a corresponding value normalization action for the first item in exchange Y, which may trigger a corresponding item token generation action for the first item in exchange Z. In example embodiments, the triggered corresponding value normalization action of the Exchange Y may be based at least in part on a result of the value normalization action of exchange X. Likewise, the item token generation action of exchange Z may be based on a result of value normalization for the item of exchange Y. In example embodiments, while workflows and/or workflow actions, and/or exchange actions may automatically be triggered across the plurality of exchanges, each such action and/or workflow may be independent, other than due to triggering, of any other action in any other exchange, including cascading workflows and actions.

In example embodiments, the methods and systems of FIG. 52 for automatic triggering of actions across exchanges may be performed by a robotic process automation service 4360 that may be trained on a set of cross exchange workflow triggering actions, such as actions taken by humans, a cross-exchange action triggering facility, and the like. Robotic process automation services 4360 may facilitate autonomous configuration of links among transaction workflows, workflow actions, and exchange actions that enable actions in a first exchange automatically triggering actions in a second exchange. Robotic process automation services 4360 may facilitate automatically triggering one or more actions in one or more workflows for one or more exchanges for a set of transaction workflows across a plurality of exchanges.

Configuring a Smart Contract from Analysis of a Set of Smart Contracts in Each of a Plurality of Exchanges

In embodiments, methods and systems may include a set of robotic process automation services that are configured to state the value of a set of items that are represented in a plurality of exchanges, such that representation of the value of each member of the set of items in the plurality of exchanges is normalized based on the native currencies of the respective exchanges and may include a set of robotic process automation services that are configured to inspect a set of smart contracts in each of a plurality of exchanges and to configure a smart contract that provides terms and conditions for a transaction that involves a transactional step in each of the plurality of exchanges.

In embodiments, methods and systems may include a set of robotic process automation services that are configured to automatically translate the value of an item represented in a first exchange into a value of the item for representation in a second exchange and may include a set of robotic process automation services that are configured to inspect a set of smart contracts in each of a plurality of exchanges and to configure a smart contract that provides terms and conditions for a transaction that involves a transactional step in each of the plurality of exchanges.

In embodiments, methods and systems may include a set of robotic process automation services that are configured to generate token that represents an item in an exchange based on characteristics of the item determined from data from a different exchange and may include a set of robotic process automation services that are configured to inspect a set of smart contracts in each of a plurality of exchanges and to configure a smart contract that provides terms and conditions for a transaction that involves a transactional step in each of the plurality of exchanges.

In embodiments, methods and systems may include a set of robotic process automation services that are configured to generate a digital representation of a set of rights relating to an item that is consistent with the governing rules of an exchange based on processing at least one of a set of smart contracts and a set of terms and conditions relating to the item and may include a set of robotic process automation services that are configured to inspect a set of smart contracts in each of a plurality of exchanges and to configure a smart contract that provides terms and conditions for a transaction that involves a transactional step in each of the plurality of exchanges.

Referring to FIG. 53 exemplary embodiments of the methods and systems for configuring a smart contract, such as a cross-exchange smart contract, that provides terms and conditions for a transaction associated with an item are depicted. The example embodiments are for applying a generated smart contract to adapt a normalized item value across transaction workflows in a plurality of exchanges. A robotic process automation service 4460 may be configured to operate and/or interact with a set of smart contract analysis services 4464 that may interface with a set of smart contract generation services 4466 to produce a cross-exchange smart contract 4470 that may be useful in one or more steps of one or more of a plurality of transaction workflows of one or more of a plurality of exchanges. A plurality of exchanges may be represented by an exemplary first exchange A 4452 that may be associated with one or more sets of smart contracts 4458 and that may optionally include a set of governing rules 4462. The exchange may process a transaction workflow 4476 that may include one or more steps for adapting a normalized item value 4474 of an item 4472. As depicted each of two additional exchanges in the plurality of exchanges, specifically exchanges B 4454 and exchange C 4456 may include one or more sets of smart contracts 4458, optionally one or more sets of governing rules 4462, an exchange-specific transaction workflow that may be similar to transaction workflow 4476 that may rely upon a cross exchange smart contract 4470 to adapt a normalized item value 4474 for an item 4472. In example embodiments, a set of smart contracts for each distinct exchange may include one or more smart contracts that may be similar to and/or distinct from other smart contracts in the set. One or more smart contracts in a set of smart contracts for a first exchange may be distinct from at least one other smart contract of at least one other exchange. In example embodiments, differences among smart contracts within and/or across exchanges may include differences in terms (e.g., effectivity start/stop dates), differences in conditions (jurisdictional differences, for example), differences driven by aspects of a corresponding exchange, and the like.

Governing rules 4462 for each of the plurality of exchanges may be configured to address exchange-specific governing factors, such as taxation, import/export regulations, exchange transaction fee structure, and many others. In example embodiments, governing rules may be optional for one or more of the plurality of exchanges.

In example embodiments, the smart contract analysis system 4464 may capture information that is descriptive of each of a plurality of smart contracts for at least a portion of the plurality of exchanges. In example embodiments, the smart contract analysis system 4464 may include a smart contract execution and/or simulation capability through which a smart contract may be simulated and monitored to capture information that is descriptive thereof, such as terms, conditions, input data sources, algorithms applied to such sources, thresholds, and the like. Through analysis of smart contracts for the portion of the plurality of exchanges, a set of terms and conditions may be determined that may be suitable for application to a set of transaction workflows. In an example, a resulting set of terms and conditions may be derived from a subset of terms and conditions that are common among the analyzed smart contracts. In this example, a common condition for each analyzed contract may include a condition that contract terms that are satisfied when the exchange is closed (e.g., after local business hours) are recorded as being satisfied when the exchange next opens (e.g., next business day and the like). In an example, a resulting set of terms and conditions may be a superset of terms and conditions from the analyzed smart contracts. In this example, a smart contract for a first exchange may include a condition that exchange data is captured hourly, and a smart contract for a second exchange may include a condition that exchange data is captured every 30 seconds. A resulting smart contract may include conditions that require exchange data to be captured every 30 seconds and every hour.

In example embodiments, a deliverable from the smart contact analysis system 4464 may include a set of terms and conditions, processing algorithms, data sources, and the like that may be adapted based on governing rules from one or more of the plurality of exchanges in a smart contract generation system 4466 that produces a smart contract that includes one or more terms and conditions from at least one of the plurality of sets of smart contracts. The smart contract generation system 4466 may further apply governing rules from each of the exchanges that apply to terms and/or conditions produced from the smart contract analysis system 4464. In example embodiments, a term for smart contact of a first exchange that survives the smart contract analysis system 4464 (e.g., that is included in a deliverable set of terms produced by the smart contract analysis system 4464) may be adapted based on a governing rule of the first exchange. In example embodiments, governing rules of a first exchange may be used to adapt at least one of term and conditions in the set of deliverables derived from analysis of a smart contract from a second exchange. As an example of application of exchange-specific governing rules to a resulting set of terms, a normalization action in a transaction workflow may be adapted to calculate the normalized value to a degree of precision defined by the governing rules. In example embodiments, if a governing rule in a first exchange defines normalized value precision to be two decimal places, and a governing rules in a second exchange defines normalized value precision to be three decimal places, a resulting cross-exchange smart contract may require normalization to three decimal places for each application of the cross-exchange smart contract. In example embodiments, a smart contract produced by the smart contract generation system 4466 may include a cross-exchange smart contract 4470.

Further in the exemplary embodiment depicted in FIG. 53, the cross-exchange smart contract 4470 may be configured to impact a transaction workflow step, such as step Y in each of a plurality of transaction workflows 4476 for a plurality of exchanges. As an example of application of a cross-exchange smart contract derived from a plurality of smart contracts, step Y in each of the plurality of transaction workflows 4476 may include accessing a normalized value for an item in the exchange, applying a smart contract-specified adjustment, and setting a transaction price in the exchange for the item. In the example embodiment of FIG. 53, the cross exchange smart contract 4470 may provide an adjustment value, an adjustment approach (e.g., an algorithm), and/or other conditions under which the accessed normalized item value is adjusted. Further the cross-exchange smart contract 4470 may be configured to prescribe an adjustment that applies to a specific exchange, to a plurality of exchanges, or to all exchanges. Yet further the cross-exchange smart contract 4470 may provide conditions under which the normalized value is adjusted that are different for one or more of the plurality of exchanges. In an example, a smart contract for exchange A may include a term that requires no adjustment in normalized value; a smart contract for exchange B may include a term that requires a conditional adjustment (e.g., based on transaction value and the like); a smart contract for exchange C may include a term that requires an adjustment to normalized value that results in rounding off the normalized value to a whole unit of local currency. Each of these terms may be configured into the cross exchange smart contract 4470 so that when it is applied to a transaction workflow, a term that corresponds to an exchange in which the transaction workflow occurs can be applied to adjust the normalized value. Through application of a cross exchange smart contract 4470, normalized item value may be automatically generated for an item across a plurality of exchanges. Further use of robotic process automation for generating cross exchange smart contracts may facilitate orchestration of transaction workflows that can be automatically and dynamically adapted.

In the exemplary normalized item value embodiments depicted in FIG. 53, use of the methods and systems for generating and applying a cross exchange smart contact 4470 may facilitate generating an exchange-specific normalized value for an item in each of a plurality of exchanges that factors in one or more terms and conditions associated with a smart contact for each of the exchanges.

In example embodiments, the methods and systems of FIG. 53 for cross-exchange smart contract generation may be performed by a robotic process automation service 4460 that may be trained on a set of smart contract generation actions, such as actions taken by humans, the smart contract analysis system 4464, the smart contract generation system 4466, and the like. Robotic process automation services 4460 may facilitate autonomous generation of a smart contract based on terms and conditions of a plurality of smart contracts across a plurality of exchanges. Robotic process automation services 4460, when combined with the smart contract analysis system capabilities and the smart contract generation system capabilities may automate generation of a cross exchange smart contract 4470 based on a plurality of exchange governing rules 4462 across the plurality of exchanges.

### Self-Adapting Asset Data Delivery Network Infrastructure Pipeline

In embodiments, provided herein are computer-implemented methods and systems for automated orchestration of one or more marketplaces, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path.

In embodiments, provided herein are computer-implemented methods and systems for automated orchestration of one or more marketplaces, such methods and systems are provided having a set of robotic process automation services that are configured to automatically translate the value of an item represented in a first exchange into a value of the item for representation in a second exchange and having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path.

In embodiments, provided herein are computer-implemented methods and systems for automated orchestration of one or more marketplaces, such methods and systems are provided having a set of robotic process automation services that are configured to generate token that represents an item in an exchange based on characteristics of the item determined from data from a different exchange and having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path.

In embodiments, provided herein are computer-implemented methods and systems for automated orchestration of one or more marketplaces, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path.

Referring to FIG. 54, a data and network infrastructure pipeline 4500 is configured to deliver data from a set of assets 4552 to one or more marketplace entities for one or more marketplaces 4568 in which transactions for portions of the sets of assets 4552 are conducted. In example embodiments, the data from the set of assets 4552 is delivered by the pipeline 4500 to an interface by which an operator orchestrates a set of parameters for a set of transaction workflows involving the assets. The pipeline 4500 may be automatically configured to adjust a network path for delivery of data from the set of assets 4552 to the interface based on the characteristics of the data and at least one performance parameter of the network path. In example embodiments, the pipeline 4500 may be automatically configured to adjust timing of asset data delivery from the set of assets 4552 to the interface based on at least one of a transaction parameter and a network performance parameter.

Referring again to FIG. 54, the data and network infrastructure pipeline 4500 may include sets of asset-centric intelligent network resources 4554 that may be disposed proximal to the set of assets 4552. These sets of asset-centric intelligent network resources 4554 may include a set of asset local resources that are configured to work cooperatively manage, for example use of network storage to preserve data delivered from the sets of assets 4552 for supporting delivery of the asset data through the pipeline 4500. These asset local resources 4554 may be configured to interface with intelligent assets, such as electronic assets. These asset local resources 4554 may automatically determine, such as through analysis of data from such electronic asset configuration parameters for interfacing with one or more corresponding electronic assets.

The data and network infrastructure pipeline 4500 may further include a set of intermediate intelligent network resources 4556 that may be adapted to deliver asset data from the asset local resources 4554 on to one or more marketplace related interfaces 4568, such as a user interface, a smart contract, and the like. The set of intermediate intelligent network resources 4556 may include a network path adaptation/determination system that facilitates adapting a network path by producing an automatically adapted network route for the asset data. Such a network path adaptation/determination system may perform network path determination based on characteristics of the asset data.

The data and network infrastructure pipeline 4500 may also include a set of marketplace-centric intelligent network resources 4566 that may be disposed proximal to recipients of the asset data, such as interfaces associated with a marketplace 4568 in which one or more transactions (and associated transaction workflows) for the assets 4552 may be conducted. Examples of marketplace-centric intelligent network resources 4566 may include an item value normalization system 4558, a cross-exchange item value translation system 4560, an item token generation system 4562, an item rights token generation system 4564, and the like.

In example embodiments, the item value normalization system 4558 may include a set of robotic process automation services that are configured to state the value of a set of items that are represented in a plurality of exchanges, such that representation of the value of each member of the set of items in the plurality of exchanges is normalized based on the native currencies of the respective exchanges, example embodiments of which are described herein, including without limitation embodiments depicted in FIG. 38, FIG. 39, and FIG. 40. In example embodiments, the cross-exchange item value translation system 4560 may include a set of robotic process automation services that are configured to automatically translate the value of an item represented in a first exchange into a value of the item for representation in a second exchange, example embodiments of which are described herein, including without limitation embodiments depicted in FIG. 41 and FIG. 42. In example embodiments, the item token generation system 4562 may include a set of robotic process automation services that are configured to generate a token that represents an item in an exchange based on characteristics of the item determined from data from a different exchange, example embodiments of which are described herein, including without limitation FIG. 43, FIG. 44, and FIG. 45. In example embodiments, the item rights token generation system 4564 may include a set of robotic process automation services that are configures for generating rights tokens (and optional corresponding smart contracts) that are representative of a set of rights relating to an item based at least in part on one or more of a smart contract of an item, or a set of terms and conditions of the item, example embodiments of which are described herein, including without limitation FIGS. 46-49.

The one or more sets of intelligent network resources, such as sets of asset-centric resources 4552, intermediate resources 4556, or sets of marketplace-centric resources 4566 may be implemented in or in association with physical resources of a data communication network, such as the Internet and the like. Sets of asset-centric resources 4554 and/or sets of marketplace (e.g., asset data recipient) centric resources 4566 may include network infrastructure resources, such as edge computing devices, inter-network interface devices (e.g., bridges, routers, and the like), aggregation devices, such as a distributed antenna system, and the like.

In embodiments, methods and systems are provided that may include a set of robotic process automation services that are configured to state the value of a set of items that are represented in a plurality of exchanges, such that representation of the value of each member of the set of items in the plurality of exchanges is normalized based on the native currencies of the respective exchanges and having a set of application programming interfaces to a marketplace that are configured to be integrated into a digital twin platform, such that interactions with a set of interfaces of the digital twin platform automatically trigger a set of transaction workflows within the marketplace.

In embodiments, methods and systems are provided that may include a set of robotic process automation services that are configured to automatically translate the value of an item represented in a first exchange into a value of the item for representation in a second exchange and having a digital twin that represents a set of entities, workflows, and transaction parameters of a plurality of exchanges, such that interaction with the interface of the digital twin can orchestrate an interaction in each of the plurality of exchanges.

In embodiments, methods and systems are provided that may include a set of robotic process automation services that are configured to generate a token that represents an item in an exchange based on characteristics of the item determined from data from a different exchange and having a digital twin that represents a set of entities, workflows, and transaction parameters of a plurality of exchanges, such that interaction with the interface of the digital twin can orchestrate an interaction in each of the plurality of exchanges.

In embodiments, methods and systems are provided that may include a set of robotic process automation services that are configured to generate a digital representation of a set of rights relating to an item that is consistent with the governing rules of an exchange based on processing at least one of a set of smart contracts and a set of terms and conditions relating to the item and having a digital twin that represents a set of entities, workflows, and transaction parameters of a plurality of exchanges, such that interaction with the interface of the digital twin can orchestrate an interaction in each of the plurality of exchanges.

In embodiments, methods and systems are provided that may include a set of robotic process automation services that are configured to generate a digital representation of a set of rights relating to an item that is consistent with the governing rules of an exchange based on processing at least one of a set of smart contracts and a set of terms and conditions relating to the item and having a set of application programming interfaces to a marketplace that are configured to be integrated into a digital twin platform, such that interactions with a set of interfaces of the digital twin platform automatically trigger a set of transaction workflows within the marketplace.

### Normalization, Translation, Item Tokens, Rights Tokens, and Combinations Thereof.

In embodiments, provided herein are computer-implemented methods and systems for automated orchestration of one or more marketplaces, such methods and systems having a set of robotic process automation services that are configured to state the value of a set of items that are represented in a plurality of exchanges, such that representation of the value of each member of the set of items in the plurality of exchanges is normalized based on the native currencies of the respective exchanges.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to automatically translate the value of an item represented in a first exchange into a value of the item for representation in a second exchange. In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to generate token that represents an item in an exchange based on characteristics of the item determined from data from a different exchange. In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to generate a digital representation of a set of rights relating to an item that is consistent with the governing rules of an exchange based on processing at least one of a set of smart contracts and a set of terms and conditions relating to the item.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to orchestrate a set of transaction workflows in each of a plurality of exchanges, such that initiation of a set of actions in one exchange automatically results in the triggering of a set of actions in at least one other exchange.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to orchestrate a set of transaction workflows in each of a plurality of exchanges, such that initiation of a set of actions in the set of transaction workflows in one exchange automatically results in the triggering of a set of corresponding/coordinating/item-centric in at least one other exchange.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to orchestrate a set of transaction workflows in each of a plurality of exchanges, such that initiation of a set of actions in the set of transaction workflows that causes/contributes to initiation of one of the set of workflows in one exchange automatically results in the triggering of a set of actions that result in activating at least one of a corresponding set of workflows in at least one other exchange.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of robotic process automation services that are configured to orchestrate a set of transaction workflows in each of a plurality of exchanges, such that initiation of a set of actions in the set of transaction workflows that causes/contributes to initiation of one of the set of workflows in one exchange automatically results in the triggering of a set of corresponding/coordinating/item-centric actions that result in activating at least one of a corresponding set of workflows in at least one other exchange. In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a digital twin that represents a set of entities, workflows, and transaction parameters of a plurality of exchanges, such that interaction with an interface of the digital twin can orchestrate an interaction in each of the plurality of exchanges.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter. In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of application programming interfaces to a marketplace that are configured to be integrated into an electronic wallet system, such that interactions with a set of interfaces of the wallet system automatically trigger a set of transaction workflows within the marketplace.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of application programming interfaces to a marketplace that are configured to be integrated into a digital twin platform, such that interactions with a set of interfaces of the digital twin platform automatically trigger a set of transaction workflows within the marketplace.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of application programming interfaces to a marketplace that are configured to be integrated into an enterprise database platform, such that interactions with a set of interfaces of the enterprise database platform automatically trigger a set of transaction workflows within the marketplace.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of application programming interfaces to a marketplace that are configured to be integrated into a platform-as-a-service platform, such that interactions with a set of interfaces of the platform-as-a-service platform automatically trigger a set of transaction workflows within the marketplace.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of application programming interfaces to a marketplace that are configured to be integrated into a computer-aided design platform, such that interactions with a set of interfaces of the computer-aided design platform automatically trigger a set of transaction workflows within the marketplace.

In embodiments, such methods and systems are provided having a set of robotic process automation services that are configured to state the value of a set of items that are represented in a plurality of exchanges, such that representation of the value of each member of the set of items in the plurality of exchanges is normalized based on the native currencies of the respective exchanges and having a set of application programming interfaces to a marketplace that are configured to be integrated into a video game, such that interactions with a set of interfaces of the video game automatically trigger a set of transaction workflows within the marketplace.

In embodiments, provided herein are computer-implemented methods and systems for automated orchestration of one or more marketplaces, such methods and systems having a set of robotic process automation services that are configured to automatically translate the value of an item represented in a first exchange into a value of the item for representation in a second exchange. In embodiments, such methods and systems are provided having a set of robotic process automation services that are configured to automatically translate the value of an item represented in a first exchange into a value of the item for representation in a second exchange and having a set of robotic process automation services that are configured to generate token that represents an item in an exchange based on characteristics of the item determined from data from a different exchange. In embodiments, such methods and systems are provided having a set of robotic process automation services that are configured to automatically translate the value of an item represented in a first exchange into a value of the item for representation in a second exchange and having a set of robotic process automation services that are configured to generate a digital representation of a set of rights relating to an item that is consistent with the governing rules of an exchange based on processing at least one of a set of smart contracts and a set of terms and conditions relating to the item. In embodiments, such methods and systems are provided having a set of robotic process automation services that are configured to automatically translate the value of an item represented in a first exchange into a value of the item for representation in a second exchange and having a set of robotic process automation services that are configured to orchestrate a set of transaction workflows in each of a plurality of exchanges, such that initiation of a set of actions in one exchange automatically results in the triggering of a set of actions in at least one other exchange. In embodiments, such methods and systems are provided having a set of robotic process automation services that are configured to automatically translate the value of an item represented in a first exchange into a value of the item for representation in a second exchange and having a digital twin that represents a set of entities, workflows, and transaction parameters of a plurality of exchanges, such that interaction with the interface of the digital twin can orchestrate an interaction in each of the plurality of exchanges. In embodiments, such methods and systems are provided having a set of robotic process automation services that are configured to automatically translate the value of an item represented in a first exchange into a value of the item for representation in a second exchange and having a set of robotic process automation services that are configured to inspect a set of smart contracts in each of a plurality of exchanges and to configure a smart contract that provides terms and conditions for a transaction that involves a transactional step in each of the plurality of exchanges. In embodiments, such methods and systems are provided having a set of robotic process automation services that are configured to automatically translate the value of an item represented in a first exchange into a value of the item for representation in a second exchange and having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path. In embodiments, such methods and systems are provided having a set of robotic process automation services that are configured to automatically translate the value of an item represented in a first exchange into a value of the item for representation in a second exchange and having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter. In embodiments, such methods and systems are provided having a set of robotic process automation services that are configured to automatically translate the value of an item represented in a first exchange into a value of the item for representation in a second exchange and having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter. In embodiments, such methods and systems are provided having a set of robotic process automation services that are configured to automatically translate the value of an item represented in a first exchange into a value of the item for representation in a second exchange and having a set of application programming interfaces to a marketplace that are configured to be integrated into an electronic wallet system, such that interactions with a set of interfaces of the wallet system automatically trigger a set of transaction workflows within the marketplace. In embodiments, such methods and systems are provided having a set of robotic process automation services that are configured to automatically translate the value of an item represented in a first exchange into a value of the item for representation in a second exchange and having a set of application programming interfaces to a marketplace that are configured to be integrated into a digital twin platform, such that interactions with a set of interfaces of the digital twin platform automatically trigger a set of transaction workflows within the marketplace. In embodiments, such methods and systems are provided having a set of robotic process automation services that are configured to automatically translate the value of an item represented in a first exchange into a value of the item for representation in a second exchange and having a set of application programming interfaces to a marketplace that are configured to be integrated into an enterprise database platform, such that interactions with a set of interfaces of the enterprise database platform automatically trigger a set of transaction workflows within the marketplace. In embodiments, such methods and systems are provided having a set of robotic process automation services that are configured to automatically translate the value of an item represented in a first exchange into a value of the item for representation in a second exchange and having a set of application programming interfaces to a marketplace that are configured to be integrated into a platform-as-a-service platform, such that interactions with a set of interfaces of the platform-as-a-service platform automatically trigger a set of transaction workflows within the marketplace. In embodiments, such methods and systems are provided having a set of robotic process automation services that are configured to automatically translate the value of an item represented in a first exchange into a value of the item for representation in a second exchange and having a set of application programming interfaces to a marketplace that are configured to be integrated into a computer-aided design platform, such that interactions with a set of interfaces of the computer-aided design platform automatically trigger a set of transaction workflows within the marketplace. In embodiments, such methods and systems are provided having a set of robotic process automation services that are configured to automatically translate the value of an item represented in a first exchange into a value of the item for representation in a second exchange and having a set of application programming interfaces to a marketplace that are configured to be integrated into a video game, such that interactions with a set of interfaces of the video game automatically trigger a set of transaction workflows within the marketplace.

In embodiments, provided herein are computer-implemented methods and systems for automated orchestration of one or more marketplaces, such methods and systems having a set of robotic process automation services that are configured to generate token that represents an item in an exchange based on characteristics of the item determined from data from a different exchange. In embodiments, such methods and systems are provided having a set of robotic process automation services that are configured to generate token that represents an item in an exchange based on characteristics of the item determined from data from a different exchange and having a set of robotic process automation services that are configured to generate a digital representation of a set of rights relating to an item that is consistent with the governing rules of an exchange based on processing at least one of a set of smart contracts and a set of terms and conditions relating to the item. In embodiments, such methods and systems are provided having a set of robotic process automation services that are configured to generate token that represents an item in an exchange based on characteristics of the item determined from data from a different exchange and having a set of robotic process automation services that are configured to orchestrate a set of transaction workflows in each of a plurality of exchanges, such that initiation of a set of actions in one exchange automatically results in the triggering of a set of actions in at least one other exchange. In embodiments, such methods and systems are provided having a set of robotic process automation services that are configured to generate token that represents an item in an exchange based on characteristics of the item determined from data from a different exchange and having a digital twin that represents a set of entities, workflows, and transaction parameters of a plurality of exchanges, such that interaction with the interface of the digital twin can orchestrate an interaction in each of the plurality of exchanges. In embodiments, such methods and systems are provided having a set of robotic process automation services that are configured to generate token that represents an item in an exchange based on characteristics of the item determined from data from a different exchange and having a set of robotic process automation services that are configured to inspect a set of smart contracts in each of a plurality of exchanges and to configure a smart contract that provides terms and conditions for a transaction that involves a transactional step in each of the plurality of exchanges. In embodiments, such methods and systems are provided having a set of robotic process automation services that are configured to generate token that represents an item in an exchange based on characteristics of the item determined from data from a different exchange and having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path. In embodiments, such methods and systems are provided having a set of robotic process automation services that are configured to generate token that represents an item in an exchange based on characteristics of the item determined from data from a different exchange and having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter. In embodiments, such methods and systems are provided having a set of robotic process automation services that are configured to generate token that represents an item in an exchange based on characteristics of the item determined from data from a different exchange and having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter. In embodiments, such methods and systems are provided having a set of robotic process automation services that are configured to generate token that represents an item in an exchange based on characteristics of the item determined from data from a different exchange and having a set of application programming interfaces to a marketplace that are configured to be integrated into an electronic wallet system, such that interactions with a set of interfaces of the wallet system automatically trigger a set of transaction workflows within the marketplace. In embodiments, such methods and systems are provided having a set of robotic process automation services that are configured to generate token that represents an item in an exchange based on characteristics of the item determined from data from a different exchange and having a set of application programming interfaces to a marketplace that are configured to be integrated into a digital twin platform, such that interactions with a set of interfaces of the digital twin platform automatically trigger a set of transaction workflows within the marketplace. In embodiments, such methods and systems are provided having a set of robotic process automation services that are configured to generate token that represents an item in an exchange based on characteristics of the item determined from data from a different exchange and having a set of application programming interfaces to a marketplace that are configured to be integrated into an enterprise database platform, such that interactions with a set of interfaces of the enterprise database platform automatically trigger a set of transaction workflows within the marketplace. In embodiments, such methods and systems are provided having a set of robotic process automation services that are configured to generate token that represents an item in an exchange based on characteristics of the item determined from data from a different exchange and having a set of application programming interfaces to a marketplace that are configured to be integrated into a platform-as-a-service platform, such that interactions with a set of interfaces of the platform-as-a-service platform automatically trigger a set of transaction workflows within the marketplace. In embodiments, such methods and systems are provided having a set of robotic process automation services that are configured to generate token that represents an item in an exchange based on characteristics of the item determined from data from a different exchange and having a set of application programming interfaces to a marketplace that are configured to be integrated into a computer-aided design platform, such that interactions with a set of interfaces of the computer-aided design platform automatically trigger a set of transaction workflows within the marketplace. In embodiments, such methods and systems are provided having a set of robotic process automation services that are configured to generate token that represents an item in an exchange based on characteristics of the item determined from data from a different exchange and having a set of application programming interfaces to a marketplace that are configured to be integrated into a video game, such that interactions with a set of interfaces of the video game automatically trigger a set of transaction workflows within the marketplace.

In embodiments, provided herein are computer-implemented methods and systems for automated orchestration of one or more marketplaces, such methods and systems having a set of robotic process automation services that are configured to generate a digital representation of a set of rights relating to an item that is consistent with the governing rules of an exchange based on processing at least one of a set of smart contracts and a set of terms and conditions relating to the item. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of robotic process automation services that are configured to orchestrate a set of transaction workflows in each of a plurality of exchanges, such that initiation of a set of actions in one exchange automatically results in the triggering of a set of actions in at least one other exchange. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a digital twin that represents a set of entities, workflows, and transaction parameters of a plurality of exchanges, such that interaction with the interface of the digital twin can orchestrate an interaction in each of the plurality of exchanges. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of robotic process automation services that are configured to inspect a set of smart contracts in each of a plurality of exchanges and to configure a smart contract that provides terms and conditions for a transaction that involves a transactional step in each of the plurality of exchanges. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of application programming interfaces to a marketplace that are configured to be integrated into an electronic wallet system, such that interactions with a set of interfaces of the wallet system automatically trigger a set of transaction workflows within the marketplace. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of application programming interfaces to a marketplace that are configured to be integrated into a digital twin platform, such that interactions with a set of interfaces of the digital twin platform automatically trigger a set of transaction workflows within the marketplace. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of application programming interfaces to a marketplace that are configured to be integrated into an enterprise database platform, such that interactions with a set of interfaces of the enterprise database platform automatically trigger a set of transaction workflows within the marketplace. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of application programming interfaces to a marketplace that are configured to be integrated into a platform-as-a-service platform, such that interactions with a set of interfaces of the platform-as-a-service platform automatically trigger a set of transaction workflows within the marketplace. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of application programming interfaces to a marketplace that are configured to be integrated into a computer-aided design platform, such that interactions with a set of interfaces of the computer-aided design platform automatically trigger a set of transaction workflows within the marketplace. In embodiments, such methods and systems are provided having a set of robotic process automation services that are configured to generate a digital representation of a set of rights relating to an item that is consistent with the governing rules of an exchange based on processing at least one of a set of smart contracts and a set of terms and conditions relating to the item and having a set of application programming interfaces to a marketplace that are configured to be integrated into a video game, such that interactions with a set of interfaces of the video game automatically trigger a set of transaction workflows within the marketplace.

### Governance

Data curation allows companies to provide personalized, high quality services to their customers. AI allows for data curation on a grander scale, providing companies with more expansive and detailed information about the usage of their product. However, AI has not proven to be a flawless data collector and curator-rather, the development of AI in the data collection and curation sphere has brought about new challenges that require governance and policy. As new laws and regulations begin to emerge surrounding the governance of AI, companies must adapt their data curation and collection to provide a system of rules that guarantees a quality of service across the network of their organization. More than ever, trust and accountability must be at the forefront of any developing AI technology. High profile incidents involving breaches of personal data have ebbed away at public trust, and AI introduces a new variable that could further destabilize the general perception of data collection and curation. Therefore, it is necessary to establish core guidelines and practices surrounding the governance of AI training data sets in their connection to neural networks. Memory Enhanced Artificial Neural Networks establish basic operating measures for AI that allow training, model verification, and algorithm validation of data sets. These practices address the biases in AI technology that stem from erroneous assumptions in the training data used in a machine learning model. These systemic prejudices could skew datasets and provide an incomplete summary based on a portion of the population that either does not accurately represent the whole or does not incorporate appropriate nuance into its analysis. In a world as diverse and interconnected as our own, these biases are hindrances that prevent companies from ensuring their customers receive the most secure and optimized user experience. MEANN and/or DPANN enable the governance of human-AI interactions to better address these biases through transparency and feedback, creating auditing systems that ensure that the A1's training data sets meet standardized rules and regulations. These networks foster transparency by providing consumer access to the training data. In embodiments, governance of a neural network may include identification, calculation, and utilization of various measures of trust of a neural network, such as ones that factor in one or more of visibility of input data, visibility of feedback factors, outcome tracking, training data set quality, model verification data set quality, algorithm validation (which in embodiments may occur within a derivative marketplace for validation), various indices (such as pricing, ranking, rating, and others), accuracy measures (including comparisons to other AI-based solutions and other systems), consistency, reliability, and various test measures (such as ones of performance, reliability, energy consumption, and others).

In embodiments, the platform 100 may include a governance system 3060 configured to create a governance parameter based on a governance goal, the governance parameter being a rule to be followed by the AI entity and embed the governance parameter into the AI deployment system. The AI deployment system is configured to apply the governance parameter governing at least one parameter of the deployment of the AI entity, such that the AI entity is trained and deployed to perform the operation in compliance with the governance parameter. The governance system 3060 may be at least partially enabled by an AI module. The AI module may be configured to perform modification of the governance parameter. The AI module may be configured to perform modification of the governance goal.

In embodiments, the AI module may be configured to determine whether, after training of the AI entity, performance of the operation by the AI entity meets the governance goal. The AI module may be configured to, upon determining that the performance of the operation by the AI entity does not meet the governance goal, modify the governance parameter. The AI module may be or include one or more of a machine learned process, an intelligent agent, and a neural network. The AI module may be or include a dual-process artificial neural network.

In embodiments, the platform 100 may include a governance interface configured to facilitate interaction with the governance system 3060 by a user. The governance interface may allow the user to input the operation that the user desires the AI entity to be trained to perform. The governance system 3060 may create the governance parameter based on the governance goal and the operation. The governance interface may allow the user to input the governance goal that the user desires the AI entity to be trained to perform. The governance system 3060 may create the governance parameter based on the governance goal. The governance interface may allow the user to view the training dataset. The governance interface may allow the user to apply the governance parameter to the training dataset. The governance interface may allow the user to view at least one of input data, feedback factors, outcome tracking, training dataset quality, model verification data set quality, algorithm validation, indices, accuracy measures, consistency, reliability, or test measures during or after training of the AI entity. The governance interface may allow the user to set at least one governance parameter governing the at least one of input data, feedback factors, outcome tracking, training dataset quality, model verification data set quality, algorithm validation, indices, accuracy measures, consistency, reliability, or test measures.

In embodiments, the governance system 3060 may be configured to determine input data, feedback factors, outcome tracking, training dataset quality, model verification data set quality, algorithm validation, indices, accuracy measures, consistency, reliability, and/or test measures during or after training of the AI entity. The governance system 3060 may be configured to determine a measure of trust of the AI entity.

In embodiments, the AI module may be configured to determine whether the AI entity meets a trust threshold. The AI module may be configured to, upon determining that the AI entity does not meet the trust threshold, modify the governance parameter.

In embodiments, the governance goal may include governing an AI-human interaction framework. The AI entity may be one or more of a machine learned process, an intelligent agent, and a neural network. The operation may include analysis of sensitive data. The systemic bias may include an erroneous assumption, the erroneous assumption causing a skew in performance of the AI entity. The governance parameter may relate to at least one of a training dataset, an input data set, a configuration parameter, a function, an output, a feedback parameter, or an objective of the AI deployment system. The operation may include a classification operation. The operation may include a prediction operation. The operation may include a recommendation operation. The operation may include an optimization operation.

In embodiments, the operation may include a control operation. The control operation may include data curation.

In embodiments, the governance goal may include reducing systemic bias of the AI entity. The governance goal may include reducing systemic bias in the training data set of the AI entity. The governance system 3060 may recommend an augmentation of the training data set of the AI entity that reduces the systemic bias.

In embodiments, governance of a neural network may include identification, calculation, and utilization of various measures of trust of a neural network, such as ones that factor in one or more of visibility of input data, visibility of feedback factors, outcome tracking, training data set quality, model verification data set quality, algorithm validation (which in embodiments may occur within a derivative marketplace for validation), various indices (such as pricing, ranking, rating, and others), accuracy measures (including comparisons to other AI-based solutions and other systems), consistency, reliability, and various test measures (such as ones of performance, reliability, energy consumption, and others). As one example, an energy policy may govern the amount, timing, and/or source of energy that is permitted to be used for an activity, such as an operational activity, computational activity, or the like, such as one that requires carbon neutrality of an overall operation, one that requires use of a fraction of renewable energy, one that requires renewable energy credits, or many others. The policy may track the amount and type of energy used for AI workloads (including workloads used to train a model and/or to run a model in operation. In embodiments, a training data set may include tracking data that indicates the energy used for model creation and the energy required for model deployment, including based on context, such as energy required under varying conditions, such as different processing environments, different network environments, and the like. Thus, an energy-governed AI model and/or energy-governed AI training data set may be provided in connection with support of marketplace operations and/or automation, and an energy-compliance measure of trust may be provided for model rating or comparison.

Traditional asset classes and new asset classes like cryptocurrency may be represented in combination in a wallet with improved visibility/transparency, increased control and transferability. Reduction of costs associated with efficiency will broaden the role of financial services into new types of markets.

Ethereum tokens enable an ethereum based system, as it is programmable and can form a smart contract. NFTs may have intrinsic value, thereby removing the economics of the token and attaching a value of the token associated with a specific piece of property. Different kinds of NFTs include a disposable asset, such as an experience (e.g., a movie ticket) or physical asset, a unique asset such as a piece of art, such as fractional ownership of a piece of art, virtual real estate (e.g., inside video games and other spaces), NFTs representing types of rights or fractional rights for ownership of goods, such as fractional ownership of a car or boat, NFTs representing verification of ownership of a physical item, specific seats or a class of seats, NFTs representing approved use, for example with drugs making sure people do not over consume, or with graphics cards the maker prefers to sell to gamers (e.g., for branding reasons), and/or NFTs representing transformation of social media, such as information about the rank within the community.

### Intelligent Data Layers

The present disclosure relates to a platform for intelligent data layers (IDLs) for facilitating and reorienting transaction flows, such as flows of software orchestrated transactions, by providing timely, contextual and transaction-impacting data for buyers, sellers, and automated platform functions, such as software orchestration. In embodiments, IDLs may actively harvest, curate, and ready transaction-derived data to facilitate cross market interactions thereby enhancing provisioning of complementary services within or as a direct derivative of transactions.

Referring to FIG. 55, a block diagram of exemplary features, capabilities, and interfaces of an exemplary embodiment of an intelligent data layer platform 5600 is depicted. Intelligent data layers (referred to herein and elsewhere as an IDL when singular and IDLs when plural) may be configured as a portion (or portions) of an IDL platform. The exemplary embodiment in FIG. 55 depicts an IDL 5604 characterized with at least one each of an ingestion, parse, analyze, and control tower elements interconnected for providing intelligence-based and other derivatives of data sources, such as IDL data sources 5602. Exemplary embodiments of 5604 are depicted and described elsewhere herein. Associated with the exemplary IDL platform 5600 of FIG. 55, IDL data sources 5602 may represent one or more sources of information, such as business data, sensor data, outputs of other IDLs, virtual data, and the like to which IDL processes may be applied. In an exemplary transaction platform deployment of IDL methods and systems, which is described elsewhere herein in greater detail, data sources 5602 may represent transaction outcomes, buyer and/or seller operating environments, market data, and the like.

In embodiments, an IDL, such as 5604 may be configured with or operationally connected to a set of application programming interfaces (APIs) through which, among other things, IDL source data may be retrieved and/o received. In exemplary embodiments, an API for an IDL may be an open/standardized API (e.g., banking/financial institution open APIs) that, among other things, may equip the IDL platform 5600 for integration with and into current and emerging eco systems. Use of open/standardized APIs, while not essential for all IDL embodiments, may further enable IDLs to integrate into a wide range of data workflows, such as corporate internal workflows, inter-jurisdiction data workflows, and the like.

An IDL platform such as 5600 may include, reference, and/or provide market orchestration elements 5608 that may facilitate use of IDL capabilities for various aspects of market orchestration, including, without limitations, software orchestrated transactions, software orchestrated marketplaces, and the like. Market orchestration elements 5608 may facilitate deployment of an IDL, such as a web service embodiment, as an integrated function of a market orchestration platform, such as an automated market orchestration system of systems as described herein. In embodiments, an IDL may provide data and network pipeline capabilities for market orchestration when configured as a portion of an IDL platform 5600 in association with market orchestration elements 5608 and the like.

IDL platform 5600 may include, reference and/or provide cross market interaction capabilities 5610 that may enable leveraging intelligence data layer principals, computation capabilities, storage and data sourcing capabilities, as well as intelligence capabilities for cross market interactions. Cross market interaction capabilities 5610 may include interfaces to one or more marketplaces, transaction environments, and the like, so that, among other things, an IDL may be configured with one market in a cross-market integration deployment as a source of data and with another market in the cross-market integration deployment as a consumer of the IDL. In embodiments, a similar arrangement may be constructed between two or more markets so that data in either market can be used as a data source and can be influenced by data from another market. Cross market interactions 5610 may be accomplished through one or more market-to-market IDLs that form data pipelines for intelligent exchange of data among markets, such as data about buyers in one market and about sellers in another.

In the exemplary IDL platform embodiment of FIG. 55, functions and processes 5612, for an exemplary market-oriented deployment may include software-oriented transaction functions and processes, automatic transaction transactions and processes, and the like. Functions and processes 5612 for an IDL platform 5600 may include signaling availability of data (e.g., emergence of an occurrence of source data) that impacts data produced by (for example) an intelligent data layer of the platform. Other exemplary functions and processes 5612 may include embedding into smart contracts, tokens, publishing data on a schedule, or other occurrence (e.g., an initiation of a smart contract and the like). Yet other functions and processes may include payments between/among machines and the like.

In embodiments, an IDL platform may include and/or be associated with intelligent data layer technology enablers 5614, such as 5G networking, artificial intelligence, visualization technology (e.g., VR/AR/XR), distributed ledger, and the like.

In embodiments, an IDL platform, such as platform 5600 may include and/or leverage cloud-based virtualized containerization capabilities and services 5616, such as without limitation a container deployment and operation controller, such as Kubernetes 5618 and the like. Cloud-based virtualized containers provide for IDLs to be deployed close to source data, thereby potentially reducing network bandwidth consumption or the potential for network disturbances in a data workflow and without substantive investment in infrastructure by the IDL operator and/or consumer.

The IDL platform of FIG. 55 may further include business system interfaces 5620, such as APIs and the like that facilitate adoption of IDLs by enterprises for development, among other things of a data-centric business workflow environment that enables cross-functional data use, seamless aggregation, and immediate contextualization of corporate data for each individual department, enterprise, subsidiary, and the like.

IDL enabled markets 5622 may be enabled by and/or enhanced through the adoption of intelligent data layer technology. Markets, such as markets at an intersection of financial service and physical product offerings may be revealed and/or enabled through application of IDLs to help parse, analyze, and provide intelligence for a wide range of market-impacting and/or related data sources. These emergent markets may be substantively constructed as a result of intelligence gathered by use of IDLs within or in association with individual markets, and the like.

Technologies that may be provided by and/or enabled by an IDL platform 5600 may include intelligence services 5624, such as artificial intelligence, machine learning and the like. These intelligence services 5624 may be provided by the platform 5600, or accessed (e.g., as third-party services) via one or more interfaces of the platform 5600. Each IDL embodiment 5604 may be provided access to these intelligence services 5624 via the platform. One or more IDL embodiments 5604 may bring to the platform its own set of intelligence services, which may be dedicated to the host IDL, or may be shareable, such as via the platform 5600 with other IDLs of the platform, for example.

In the exemplary embodiment of FIG. 55, transaction/market-oriented capabilities, services, and deployment may include market platforms 5626, transaction flows 5628, buyers 5632, sellers 5631, and intelligent data layers that enrich transactions, transaction services and the like 5630. For multi-party transaction environments, a plurality of IDLs may be configured and operated to satisfy a range of consumer needs for market analysis, transaction efficiencies, cost containment, buy/sell decisions and the like.

Referring to FIG. 56, an exemplary intelligent data layer 5700 architecture is depicted. The exemplary IDL architecture includes a controlled pipeline of data processing stages that process data from one of a plurality of data sources 5702. The controlled pipeline includes an ingestion stage 5704, an analysis stage 5706, a derived intelligence stage 5708, and an optional publisher stage 5710. The ingestion stage 5704 receives and/or harvests data from one or more of the plurality of sources 5702. Ingestion stage processing may include parsing content of data sources, such as to determine structure, content, relationships among data elements, intended meaning of the data elements, relationships between data, structure, and meaning, and the like. In embodiments, an ingestion facility that may operate at the ingestion stage 5704 may be configured to be aware of data source aspects, such as structure, etc. Ingestion stage 5704 may be preconfigured, such as by an operator of the layer, a platform controller, an intelligent data layer controller 5712, and the like. Configuration of the ingestion stage 5704 may be based on one or more data structures that represent aspects of one or more of the data sources 5702. One such aspect is a location of the data source, such as an Internet or other type of address (e.g., URL, port number, stream identifier, publication and/or broad channel, sensor output location, and the like) from which data may be accessed, queried, pulled, downloaded, streamed or otherwise accessed. Another such aspect of a data source that may be included in a configuration of the ingestion stage 5704 may include an interface method or protocol, such as through an Application Programming Interface, data transfer handshake, Internet Protocol, query language, data block size, access rate (e.g., maximum, frequency, or other timing-related parameter related to accessing the data source) and the like. Yet other aspects of a data source 5702 that may be useful when configuring an ingestion stage 5704 of an intelligent data layer 5700 may include one or more meanings of data from the data source, such as may be represented through a data source ontology and the like. Information such as units, scalars and the like for numerical values provided from the data source may be represented in an ingestion stage configuration data structure. In an example of data sources providing measurement data, a first source may provide numerical values in inches, a second source may provide values in meters, and a third source may provide values in light years. This local data source context may prove useful for relating data sources. In an example of data sources providing reputation rating values, an ontology for each source that establishes a minimum value, maximum value, and increments therebetween provides a way of establishing meaning of a data element from such a source. In yet another example of aspects of a data source that may be usefully applied when configuring at least an ingestion stage 5704 of the intelligent data layer 5700, a data source may impose or be arranged with a geometry/structure that may imbue meaning on data values, relationships among data values, and the like. One exemplary embodiment of a structure that impacts meaning and relationships of data value from a data source is a hierarchical arrangement of the data. When an ingestion facility 5704 is configured to receive/retrieve and process data that is configured as a hierarchy, the ingestion facility 5704 may be configured to assign a relationship attribute to a pair of data values that are configured as parent/child in the hierarchy. Likewise, a rule that may be applied in the hierarchy, such as certain types of changes to a parent data value impacting a corresponding child data value establish an immutable relationship between the data values as they are processed through the ingestion processing pipeline (e.g., ingestion, analysis, and intelligence).

Configuration of the ingestion stage 5704 may be automated, such as through programmatic configuration of data values in an ingestion stage execution data structure. These data values may be retrieved from, for example, an ingestion parameters portion of an IDL data processing data structure 5718. Configuration of the ingestion stage 5704 may be further automated through performing data parsing operations, and the like of data from a data source to determine aspects, such as the exemplary aspects described above. Yet further intelligence functions, such as machine learning may facilitate training an artificial intelligence system to identify aspects of a data source that are relevant for configuring an ingestion stage 5704 to receive and process its data. In embodiments, configuration of an ingestion stage 5704 may be performed at least in part by an intelligent data layer control tower 5712.

In embodiments, an ingestion stage, such as ingestion stage 5704 may develop an understanding of data sources, such as meaning of data values. In embodiments, developing an understanding may be in context of an expected use of data from one or more data sources, such as use of the data for determining a status of a term of a smart contract, a result of a software orchestrated transaction, and the like. Further data from data sources may be understood within a context of other data sources, such as other data sources from which the ingestion stage 5704 receives data. In an example of such understanding, a plurality of marketplace monitors may capture data regarding activity within a marketplace. When data from one of the marketplace monitors is placed in context of marketplace transactions, data from other marketplace monitors may be understood in this context, so that data values associated with transactions within the marketplace may be evaluated objectively against other source data descriptive of the marketplace activity.

The ingestion stage 5704 may further be configured to maintain a schedule of collection activity for one or more of the data sources 5702. A collection schedule may be one of a plurality of aspects associated with ingestion that may be influenced by data sources and by IDL pipeline processing needs (e.g., to satisfy needs of a user of the IDL). Such a collection schedule may be based on a rate or occurrence of availability of new or revised data from a source. In embodiments, some data sources may produce new/updated data on a schedule determined from activities associated with the data source, such as a sample schedule of a sensor and the like. In an example, a business rule for a system that produces data available through a data source may limit data releases periodically (e.g., such as at the end of a work shift, once per day, and the like). In another example of data source-dependent collection activity performed by an ingestion stage 5704, data may be made available based on events, such as completion of marketplace transactions and the like. An ingestion stage may monitor for such events. In an event monitoring example, the ingestion stage may monitor a port on a data network for an indication of data availability at a data source. When the ingestion stage 5704 detects the indication (e.g., a change in a data value of the port), an ingestion process may commence.

Other information of processes related to ingestion may include costs, such as costs to perform data source access, ingestion processing and the like. Cost for data collection may include access fees charged by a data source (e.g., subscription costs, access event costs, demand-based costs, and the like). Costs for data collection may be based at least in part on an amount that a consumer (e.g., a user of capabilities and output from an intelligent data layer) pays for access to information produced by the intelligent data layer that is based at least in part on data from the data source. In an example of consumption-based ingestion fees, an intelligent data layer may ingest and process data from a data source without initial payment to the data source and instead may make payment based on use of the data by consumers of the intelligent data layer. In embodiments, costs to perform data source access may be in the form of a credit to an operator of the intelligent data layer, such as when a data source provides a form of payment for use of its data. There may be a range of cost structures for source data access, at least some of which may be based on data source reputation, relevance of data from the data source, timeliness of updates of the data from the data source, and the like. In an exemplary embodiment, an intelligent data layer may access data from a data source and utilize it a plurality of times to produce layer intelligence for a plurality of users of the intelligent data layer. Costs for access and for the occurrences of use of the accessed data may be different from each other, such as a cost to access may be a multiple of (e.g., 2-time, 10-times and the like) of a cost for each subsequent occurrence of use of the accessed data.

In embodiments, an intelligent data layer may be configured as a component of a producer of source data, so that a corresponding ingestion facility may be owned (and optionally operated) by the data producer. In an example of data source owned intelligent data layers, a data source may retain privacy of its source data by exposing, such as through publication and the like, an output of the owned intelligent data layer, which may include information derived from the source data or select portions of the source data, such as non-confidential information associated with marketplace transactions and the like.

In embodiments, activities of an ingestion stage, such as ingestion stage 5704 may be affected by factors not directly related to a data source (e.g., data availability schedule and the like). Factors that may influence ingestion stage activity may include a determination about why the source data is being ingested. As an ample, an ingestion activity factor may include an arrangement (e.g., a contractual term of a smart contract and the like) between a producer of the content (e.g., a marketplace orchestrator) and a consumer of intelligence derived from the content by the intelligent data layer (e.g., a transactor of the marketplace). In this example, who is producing the data and who is consuming IDL intelligence of the data may influence ingestion activity. When two different consumers have different ingestion requirements for data from a single data source, ingestion activity for the data source may be impacted differently. One basic example is rate of update of source data-based intelligence processing. One consumer may require daily intelligence updates, whereas another consumer may require weekly updates. One consumer may require intelligence based on aggregations of data from a plurality of sources and another may require intelligence based on a single source of the plurality of sources. In these basic examples, ingestion activity for data from a single data source may vary. In addition to different use schedules and multiple source aggregation, a purpose of use of intelligence derived from data from a data source may influence ingestion stage activity. The ingestion stage 5704, optionally directed by the intelligent data layer control tower 5712 may determine that security use of derived intelligence may have a higher priority for ingestion than other uses, such as monitoring shipping status and the like. Higher priority use may influence ingestion activity by, for example, ensuring that ingestion from a source used to generate security intelligence is performed ahead of other lower priority ingestion activities.

Other factors that may affect ingestion stage 5704 activity may be time-constraint based. Factors such as source data validity phases (e.g., data from an access of data from a data source may be tagged with an expiration date), aging factors (e.g., over time an instance of data access may have less relevance), and the like may impact ingestion activity as well as impact other stages of an intelligent data layer pipeline. Ingestion stage (and other pipeline stage) activity may be influenced by other time-constraint based factors, such as collection/availability cycle and related timing. In an exemplary embodiment, a data source may provide access to its data (e.g., via a network port and the like) based on an access schedule, such as a daily access window between 2 AM and 5 AM local time. An ingestion stage 5704 may be configured and/or controlled to ensure to access data from the data source during the access window. Other time-constraint based factors that may impact ingestion activity includes relative timing constraints, such as data availability from a first data source may be dependent on updates to data from a second data source. An example of such a data source availability relationship may be found in a transaction-oriented environment, where data from an inventory data source would be dependent on changes to data in a sales transaction data source. In another example, availability of data from data source providing results of transactions may be dependent on transaction execution timing, settlement timing, a right of last refusal window, and the like associated with a transaction. In these examples, relationships among data sources indicate sequences of ingestion that may be enacted by an intelligent data layer.

Yet further operation of an intelligent data layer 5700, including ingestion operation may also be based on a method of data collection. In embodiments, a data source 5702 may be part of a data supply chain. An exemplary embodiment of a data supply chain may include a physical chain, such as may be embodied by a set of physical sensors (e.g., industrial internet of things sensors) that capture physical activity (e.g., of an industrial machine, and the like) and provide a representation of that activity as a form of data. A physical connection, such as a set of networked devices (e.g., the Internet), may convey the representation of the activity produced by the sensor(s) to, for example, a physical access port (e.g., a networked computer and the like) from which an intelligent data layer may ingest this data. Other types of data collection may include logical supply chains, such as data marts, data marketplaces, aggregated data publishers, and the like. In embodiments, data representative of a physical activity, such as a production machine in an enterprise, may be provided through a physical interface that presents the data from a corresponding sensor as it changes in near real time. That same data may be provided through a logical interface, such as a data base that facilitates access to a plurality of values of data from the sensor, optionally with a capture time, capture sequence and the like to enable batched or delayed use of data from the data source. An ingestion stage 5704 of an intelligent data layer 5700 may be controlled to capture the physical near realtime data, the stored data, or both to meet various needs of the intelligent data layer. In an example, a market maker may utilize intelligence derived from a live feed of commodity pricing data to adjust its bid/ask pricing activity. The market maker may utilize intelligence derived from the stored data values to determine its bid/ask volume activity.

As referenced above, meaning of data from a data source may be relied upon for various intelligent data layer operations, such as parsing source data, generating intelligence therefrom and the like. A data supply chain may turn raw data (e.g., from a physical sensor) into contextual data thereby overlaying meaning based on the context onto the data. An ingestion stage 5704 may adapt operation, such as a parsing operation based on such data supply chain activity. Whereas raw sensor data may be parsed according to a specification for a physical sensor, for example, contextually adapted data may be parsed according to the contextual overlay as well as the raw data definition. As an example, raw sensor data may be accurate to three decimal places, whereas the raw data when contextualized may only be presented with a single decimal place. Raw sensor activity data that records start and stop times of an activity may be accurate to the second, whereas that activity data in a practical context may only need to be represented in whole minutes. In embodiments, the ingestion stage 5704 may apply contextual constraints upon raw data, thereby adjusting at least one aspect of the raw data (e.g., a number of decimal places) based on the context.

In embodiments, the ingestion stage 5704 may be in communication with the intelligent data layer control tower 5712. As noted above, the intelligent data layer control tower 5712 may communicate configuration to the ingestion stage 5704 as well as control all aspects of activity of the ingestion stage 5704. In embodiments, the ingestion stage 5704 may be a set of ingestion and parsing algorithms as well as other ingestion functions described herein that may execute on one or more processors. These one or more processors may comprise the intelligent data layer control tower 5712. In such embodiments, the ingestion stage 5704 may be integrated into the intelligent data layer control tower 5712. Further in such embodiments, the ingestion stage 5704 may execute in virtual containers on, for example, cloud computing systems that are distinct from a physical embodiment of the intelligent data layer control tower 5712.

The ingestion stage 5704 may communicate ingested data, results of ingestion, results of parsing, and the like to the intelligent data layer control tower 5712.

Referring further to FIG. 56, an intelligent data layer pipeline may include an analysis stage 5706 that may receive data from the ingestion stage 5704. The analysis stage 5706 may receive raw ingestion data, adapted ingestion data (e.g., contextually adjusted), data derived from ingestion data (e.g., differences between sequential accesses of a single data source), metadata associated with the ingestion data (e.g., validity window, units, access costs, and the like), and the like.

The analysis stage 5706 may perform various operations on ingestion stage 5704 parsing and other ingestion activity results based on a range of factors, such as comparing data from a plurality of sources for similarity, fitness to a purpose, differences, based on types of data within or across data sources and the like. In embodiments, analysis may include comparing sources against a target use of intelligence derived from a data source. Analysis of ingestion results may attempt to determine if one or more data elements from a data source may meet consumption target requirements, such as meeting a validity time constraint, an accuracy constraint, a frequency of update constraint, relevance to a consumption subject matter focus, and the like. In embodiments, an intelligent data layer may target providing intelligence for buyers of services in a software orchestrated transaction marketplace. The analysis stage 5706 may determine if one or more data elements from one or more data sources 5702 may be relevant for generating intelligence about the services and based on the results of analysis may indicate to the intelligent data layer control tower 5712 to utilize the data for generating derived intelligence. An intelligent data layer 5700 may publish or otherwise convey requests for data, such as types of data, and the like that one or more data sources may attempt to meet. The analysis stage 5706 may determine if ingested data meets requirements of the published request for data, such as if the data complies with one or more parameters in the request.

In embodiments, the analysis stage 5706 may facilitate configuring data in the layer for publication, such as configuring one or more advertisements that characterize the ingested data in terms of potential intelligence value, relevance and the like. Examples include making data, such as derived intelligence data available on a marketplace (e.g., configuring indexing schemes and the like), making the content searchable (e.g., identifying keywords, terms, values, or the like that may facilitate discovery of intelligence derived from the ingested data through use of a search capability. The analysis stage 5706 may facilitate access visibility to information of the intelligent data layer by publishing, communicating, or broadcasting samples of the data over a network, directly to potential consumers and the like. In embodiments, potential consumers of intelligent data layer intelligence and services may include other intelligent data layers, existing data supply chain participants, and the like.

In embodiments, the analysis stage 5706 may suggest, predict, and/or estimate value of ingested data for a plurality of different consumers. These estimates may be used by the control tower to impact intelligent data layer functions, such as IDL intelligence pricing and the like that may be differentiated for different users. Further, such analysis may indicate that intelligence derived from a first data source may be more or less valuable to different target consumers.

The analysis stage 5706 may use feedback from intelligent data layer users regarding, among other things, usefulness of intelligence derived from one or more data sources 5702 to facilitate ingestion and analysis activities and the like. In an example, positive feedback on intelligence derived from a data source may result in communication from the analysis stage 5706 to the data layer control tower 5712 to make use of the data source for deriving other types of intelligence and the like. Feedback handled by the analysis stage 5706 may include feedback from uses of similar data, such as use of data from different sources that may be determined to be similar. In an example, positive feedback regarding use of a data from a first data source may trigger the publishing requests for similar data. Feedback handled by the analysis stage 5706 may be based on similar intelligent data layers.

In embodiments, multiple intelligent data layers may collaborate to meet data consumer needs, such as cross market transaction environments and the like. An analysis stage 5706 of a first IDL (e.g., for producing market intelligence for a product market) may collaborate with an analysis stage of a second IDL (e.g., for producing market intelligence for a service market). In embodiments, IDL collaboration may be enabled through exchange of data, such as by a first collaborating IDL analysis stage producing analysis results that are provided as a data source for a second collaborating IDL.

In embodiments, an IDL may ingest data from a plurality of data sources; each such set of data may be individually analyzed by the analysis stage 5706. However, the analysis stage 5706 may analyze data from a plurality of data sources, such as by aggregating data from the plurality of sources. In embodiments, data from a plurality of data sources may be parsed, such as by the ingestion stage 5704 so that data with similar characteristics (e.g., data that is indicative of a buyer reputation) may be aggregated and analyzed by the analysis stage 5706. Examples of multiple data sources that may provide data with similar characteristics include mobile devices, types of sensors, market-focused transaction systems (e.g., commodity trading, resource exchange, currency exchange markets and the like). In embodiments, the analysis stage 5706 may be in communication with the intelligent data layer control tower 5712. As noted above, the intelligent data layer control tower 5712 may communicate configuration data (e.g., sets of data that enable the analysis stage 5706 to perform various analysis functions) to the analysis stage 5706 as well as control all aspects of activity of the analysis stage 5706. In embodiments, the analysis stage 5706 may be a set of analysis algorithms that may execute on one or more processors. These one or more processors may comprise the intelligent data layer control tower 5712. In such embodiments, the analysis stage 5706 may be integrated into the intelligent data layer control tower 5712. Further in such embodiments, the analysis stage 5706 may execute in virtual containers on, for example, cloud computing systems that are distinct from a physical embodiment of the intelligent data layer control tower 5712.

The analysis stage 5706 may communicate ingested data, results of analysis, information received from an ingestion stage 5704, and the like to the intelligent data layer control tower 5712.

A stage in an intelligent data layer pipeline may include an intelligence stage 5708. An intelligence stage 5708 may utilize artificial intelligence capabilities to develop an understanding about data sources including, among things, uses of data, values of data, applicability of data, collection patterns and relevance to intelligence consumption and the like. Additional intelligence that may be derived by intelligence stage 5708 may include, without limitation, layer specific data relevance, relevance of data from one layer to another, value of intelligence to a consumer, such as to a transactor. In an example, intelligence stage 5708 may derive intelligence useful for forming new marketplaces from transactional data gathered from an existing marketplace.

In embodiments, the intelligence stage 5708 may be in communication with the intelligent data layer control tower 5712. As noted above, the intelligent data layer control tower 5712 may communicate configuration data (e.g., sets of data that enable the intelligence stage 5708 to perform various intelligence functions) to the intelligence stage 5708 as well as control all aspects of activity of the intelligence stage 5708. In embodiments, the intelligence stage 5708 may be a set of intelligence algorithms that may execute on one or more processors. These one or more processors may comprise the intelligent data layer control tower 5712. In such embodiments, the intelligence stage 5708 may be integrated into the intelligent data layer control tower 5712. Further in such embodiments, the intelligence stage 5708 may execute in virtual containers on, for example, cloud computing systems that are distinct from a physical embodiment of the intelligent data layer control tower 5712.

The intelligence stage 5708 may communicate data received from the analysis stage 5706, derived intelligence, and the like to the intelligent data layer control tower 5712.

Referring further to FIG. 56, the intelligent data layer 5700 may include a consumer portal 5710 that may communicate with elements of the IDL pipeline, such as the intelligence stage 5708 from which the consumer portal may receive derived intelligence. The consumer portal 5710 may facilitate access to derived intelligence (and optionally to other data of the intelligent data layer 5700). The consumer portal 5710 may announce availability of derived intelligence to a preconfigured set of consumers and candidate consumers through use of a messaging channel (e.g., SMS messaging and the like). The consumer portal 5710 may announce derived intelligence through various other techniques including, broadcasting across one or more communication channels (e.g., TWITTER™, and the like). The consumer portal 5710 may deliver at least select derived intelligence to intelligent data layer consumers based on a subscription or similar arrangement between the consumer(s) and the intelligent data layer. In embodiments, the consumer portal 5710 may reference (or be provided, such as by the intelligent data layer control tower 5712) intelligence publication configuration data that may identify which consumers are to receive which portion(s) of intelligence derived from which data source and cause the derived intelligence to be provided to (and/or made available to) one or more consumers based on this intelligence publication data. The intelligence publication data may be stored, such as in an intelligent data layer data store 5720 and accessed by the consumer portal 5710 via, for example, an IDL data store access function of the intelligent data layer control tower 5712. The consumer portal 5710 may also communicate with the intelligent data layer control tower 5712, such as to receive configuration, access intelligence data, analyzed data, ingested data and the like.

The consumer portal 5710 may further receive from one or more IDL data consumers, consumer preferences for interfacing with the consumer, requests for updates to previously communicated derived intelligence data, requests for onboarding, feedback on uses of derived intelligence data and the like. In embodiments, a consumer may communicate a derived intelligence delivery schedule to the consumer portal 5710 where it may be combined with other intelligence delivery data, such as other consumer delivery schedules, and the like and utilized by the consumer portal (5710) and/or the intelligent data layer control tower 5712 when performing derived intelligence delivery and communication functions.

An intelligent data layer may include and/or reference an intelligent data layer control tower 5712 that may provide configuration, control, storage, and processing capabilities for the IDL, such as for providing access by an ingestion stage 5704 to ingestion algorithms, facilitating access by a derived intelligence stage 5708 to intelligence services 5714, managing storage of an intelligent data layer configuration data store 5718, managing storage of intelligent data layer ingestion data and outcomes, analysis outcomes, derived intelligence and the like in an IDL data store 5720, and without limitation providing a mechanism by which a user, such as an owner and/or operator of the intelligent data layer 5700 can configure and otherwise interface with the modules of the intelligent data layer. In embodiments, the intelligent data layer control tower 5712 may provide (or provide access to) processing capabilities that may be used by the various stages, such as the ingestion stage 5704, the analysis stage 5706, the derived intelligence stage 5708, the consumer portal 5710, the intelligence services 5714, and the like.

In an exemplary embodiment, the intelligent data layer control tower 5712 may function in cooperation with the ingestion stage 5704 to gather and store ingestion parameters for use when executing various ingestion activities, such as determining availability of newly refreshed data from one of a plurality of data sources 5702 (e.g., a schedule of release of new data or a port address of an indicator of new data status). In embodiments, parsing data may include use of a parsing key set of ingestion parameters and the like. These parameters may be accessed in the intelligent data layer configuration data store 5718.

In another exemplary embodiment, the intelligent data layer control tower 5712 may facilitate access to analysis algorithms by the analysis stage 5706. Further the intelligent data layer control tower 5712 may work cooperatively with an algorithm portal 5716 to receive algorithms for analysis, ingestion, deriving intelligence, and the like. As an example, a data source 5702 may identify and/or provide one or more ingestion algorithms for performing ingestion actions on data provided from the source. The algorithm may be provided through the algorithm portal 5716 received and optionally vetted by the intelligent data layer control tower 5712 and stored in the intelligent data layer configuration data store 5718. In another exemplary embodiment of use of the algorithm portal 5716, a consumer may provide an algorithm for deriving intelligence from data under the consumer's control, such as in a marketplace transaction environment in which a seller provides transaction data as a source of data to the intelligent data layer for processing, optionally with other relevant data, for deriving intelligence associated with seller marketplace activities. In embodiments, deployment of an intelligent data layer as part of a data workflow for an enterprise may involve adapting existing workflow steps with intelligent data layer capabilities. As an example, a purchasing department of an enterprise may have a set of algorithms that are used to process sales forecast data for generating purchasing guidelines. An intelligent data layer may be constructed for the enterprise that produces intelligence regarding the generated purchasing guidelines by utilizing sales forecast processing algorithms that have been uploaded through, for example, the algorithm portal 5716.

In embodiments, the intelligence services 5714 may include a range of intelligence functions and capabilities including, without limitation artificial intelligence functions, machine learning functions, neural network functions, prediction capabilities, and many others. In an example of intelligence services 5714 for an intelligent data layer 5700, an ingestion stage 5704 may provide data from a data source, along with associated descriptive information (e.g., metadata, structural data, ontology data and the like) to a self-learning neural network capability of the intelligence services 5714 to aid in determining an approach to parsing the data source.

Intelligence services may further have access to subject matter associated intelligence, such as cross-market intelligence gathered through processing, optionally external to the intelligent data layer 5700, marketplace configuration, operational, and transaction outcomes for different sets of cross-market offerings. In continuing the example above of use of intelligence services for ingestion, this subject matter intelligence may be applied when a data source is determined to be related to a product or other offering that is similar to products or offerings on which the subject matter intelligence is based. So, if a source of data relates to a product (e.g., mobile device) and subject matter intelligence known to the intelligence services 5714 is based on or associated with mobile device technology, the corresponding intelligence services may be utilized for enhancing/optimizing pipeline operations being performed on the source data.

In embodiments, an intelligent data layer, such as intelligent data layer 5700 as depicted in FIG. 56, may include a user interface 5722 through which a user, such as an operator and the like, may interface with modules of the IDL and the like (e.g., query and maintain data in the parameter data store 5718 or the pipeline data store 5720). The user interface 5722 may facilitate configuring portions of the intelligent data layer, such as the algorithm portal, data retention rules for data stored in the IDL data store 5720, prioritization of use of the intelligent data layer resources by data consumers, and the like.

Referring to 260, an intelligent data layer embodied as an accessible service, such as a service available to the public for accessing intelligence from a range of data sources. In embodiments, the intelligent data layer embodiment of 260 may operate independently to provide intelligence determination services for data consumers. The independent intelligent data layer of 260 may be hired/rented/utilized by a plurality of independent data consumers, such as through payment of a subscription fee, one-time use fee, and the like. In embodiments, the independent intelligence data layer of 260 depicts an entity for producing data for a plurality of data consumers. A micro-service architecture, such as described herein and elsewhere, may further enable isolated and independent processing throughout the layer operating pipeline for each consumer, such as by initiating a virtualized container to perform one or more of the intelligent data layer pipeline functions for each data consumer (e.g., consumer X, Y, Z). In an example, a virtualized container may be operated (e.g., on a cloud processing architecture that has low latency access to data being processed in the container). In embodiments, low latency access here may include, without limitation, local access, such as a data processing server in a networked data storage facility and the like. A virtualized container may be configured with a consumer-specific instance of the ingestion stage 5804. In this example, the consumer-specific instance of the ingestion stage 5804 may be configured with consumer-specific ingestion parameters and/or functions, so as to, for example, listen to certain source data channels 5816 designated and/or selected when configuring the ingestion stage instance for the consumer. In embodiments, an intelligence derivation stage 5808 of the intelligent data layer pipeline may be instantiated in, for example, a virtualized container environment. The instance may be configured with intelligence derivation algorithms associated with a specific consumer, such as data consumer Y 5812.

While data consumer-specific instances of pipeline stage services are described as possible embodiments for the independent intelligent data layer of 260, other architectures are possible and contemplated herein. One such architecture is abstracting (e.g., through use of virtualized containers) use of pipeline stage functions that operate on one or more servers. In this example architecture, a core pipeline stage service may operate on a server with data for a plurality of data consumers being stored in a low-latency data storage facility. In this example embodiment, virtualization facilitates on-demand access to the computing capabilities of the server and more specifically to the computing capabilities and functions of the pipeline stage services, while isolating input data, in-process data, configuration data, and intelligence outcomes so that each consumer appears to have full access to the intelligent data layer based on their needs.

In yet another exemplary embodiment, a plurality of functions of the intelligent data layer may be instantiated within or associated with a virtualized container environment that may be dedicated to providing intelligence services to a specific data consumer or set of data consumers. In this way, ingestion, analysis, intelligence, control tower, storage, and publishing (e.g., producing a data and/or intelligence feed for the specific consumer) may be logically configured within a virtualized environment for providing intelligent data layer services independently of other consumers.

The embodiment of 260 may be differentiated from other embodiments, such as embodiments where an intelligent data layer is integrated into a data consumer (or optionally a data supplier) computing environment.

Data layer processing stage elements 5804, 5806, and 5808 may, for purposes of disclosure efficiency, be substantially, although not exhaustively, as described in corresponding elements 5704, 5706, and 5708 from FIG. 56 respectively. Further, some features of a corresponding stage in FIG. 56 may, in embodiments, be configured differently or excluded from a corresponding stage in 260. As an example, the ingestion stage 5704 may include data conversion capabilities that may be excluded from embodiments of the ingestion stage 5804, at least for instances where those capabilities are not needed, such as when an instance of the ingestion stage 5804 is ingesting data from a source for which at least some types of data conversion are not required.

In embodiments, ingestion stage 5804 may, in addition to interfacing with data sources 5802 (that may be, for purpose of compact disclosure, substantially, although not exhaustively, as described in corresponding element 5702 from FIG. 56) may further interface with data channels 5816 and on-demand data sources 5818. The data channels 5816 may be serviced by an ingestion stage, using, for example, a channel listening function that may be controlled by and/or integrated with intelligent data layer control tower 5820. In embodiments, data consumers may indicate, such as through configuration of the consumption parameters 5822 and the like specific channel(s) of data from which, for example intelligence is desired, or from which data is required for processing in one or more of the intelligent data layer processing pipeline stages based on, for example, configuration data for a consumer-specific instance of the intelligent data layer. A data consumer, such as data consumer X 5810 may indicate that a channel that delivers a stream of transactions within or for an institution or marketplace as a channel source of data from which or in association with which the data consumer desires derived intelligence. As an example, a buyer associated with a transaction marketplace, may desire to be informed, such as through use of the methods and systems of intelligence data layers described herein, of intelligence to be derived from a stream of transaction outcomes provided on a secondary marketplace channel. In this example, the intelligent data layer control tower 5820 may process consumption parameters 5822 to configure a schedule for listening to secondary market transaction outcomes. The consumption parameters for consumer X may, in this example also define one or more of ingestion and/or analysis, and/or derived intelligence algorithms and/or processes to be applied when processing those outcomes along the pipeline (as streamed, in batch or the like as may be specified in, for example, the consumption parameters 5822 for consumer X 5810) via the ingestion stage 5804, the analysis stage 5806, and the intelligence stage 5808. In embodiments, data channels 5816 may also publish data according to a publication schedule. The intelligent data layer control tower 5820 may coordinate the consumption parameters 5822 with each channel's publication schedule so that the ingestion stage 5804 connects with a channel that corresponds to the consumption parameters 5822 contemporaneous with the scheduled publication time. In an example, an instance of the ingestion stage 5804 may be configured to begin listening for data from a specific channel or channels before or at a start of a scheduled publication. Alternatively, the ingestion stage 5804 may be configured and/or activated to begin listening at a point in time relative to the start of scheduled publication, such as after a preamble of the publication, at an initiation of publication of detailed data values, at or near to an end of publication of detailed data values, or after a configurable number of publication steps, and the like.

As noted elsewhere herein intelligence may be derived from source content, structure, and metadata, among other things. In embodiments, intelligence associated with a data channel 5816 may be derived based at least in part on the respective channel's publication schedule. One example of intelligence that may be based on a publication schedule includes awareness of timing of potential changes in data from the channel. Therefore, changes in resulting intelligence may be adapted based on the schedule, such as indicating that intelligence derived prior to a new data publication schedule may be deemed to be “aged” (e.g., weighted lower than more updated intelligence and the like). Time-based averaging of data from such a source may be synchronized with its publication schedule.

As noted herein, another potential source of data may include on-demand data sources 5818. Unlike channels of data, such as data channels 5816 that may publish data on a schedule or based on events or the like, an on-demand data source 5818 may be controlled, such as by the intelligent data layer control tower 5820 to generate (e.g., publish or make available) data when requested. An on-demand data source 5818 may include devices that “sleep” by activating a lower power mode in between requests (demands) for data. While depicted as individual entities, data sources that provide channels 5816 and data sources that provide on-demand data 5818 may not be distinct. A single data source may provide a plurality of data interfaces, including in this example an on-demand interface and a publication channel interface.

The independent intelligent data layer 5800 may include a configuration data storage facility 5822 that may include, among other things, consumption parameter storage for each of a plurality of clients/consumers/users of the layer 5800, such as consumer X 5810, consumer Y 5812 and/or consumer Z 5814 and the like. In embodiments, layer configuration data for a data consumer may be stored separately from the parameter storage 5822 and may be accessed through, for example, a link to the separate configuration data in the parameter storage 5822. Configuration parameter storage facility 5822 (e.g., that may be virtualized and the like) may be configured with data consumer distinct portions to facilitate isolation between users of the layer 5800. A type of configuration parameter that may be accessible in or through the configuration parameter storage facility 5822 may include ingestion parameters, such as for facilitate control of ingestion activities by, for example, the intelligent data layer control tower 5820, an instance (e.g., in a virtualized container) of the ingestion stage 5804 and the like.

The layer configuration storage facility 5822 may be accessed by a data consumer of the data layer 5800 through various computer-to-computer protocols, including networked storage protocols, streaming protocols, indirect access protocols (e.g., through a proxy service that provides access to the storage) and the like.

In the exemplary embodiment of 260, configuration data may include information that facilitates ingestion (e.g., data sources and ingestion controls), analysis (e.g., data source processing, data source relationships, and the like), intelligence (e.g., intelligence algorithms, and/or identification of third-party intelligence services to be used when processing data for the consumer) and the like.

An intelligent data layer 5800 may include and/or have access to artificial intelligence services, such as machine learning services to enhance, among other things, handling of configuration parameters, such as ingestion parameters, data weights and the like that impact operations of the pipeline stages. In embodiments, machine learning 5824 may facilitate processing feedback, such as results of deriving intelligence via the intelligence stage 5808, data analysis outcomes via the analysis stage 5806, ingestion processing (e.g., data parsing and the like) via the ingestion stage 5804 and the like. In an example of machine learning-enabled feedback utilization, a set of consumption parameters (e.g., including a minimum window of time after ingestion of data from a data source 5802) may be adapted based on learning from outcomes of intelligence derived from the ingested data. The feedback may facilitate identifying an impact on the derived intelligence based on an amount of time since last ingestion from the data source. A machine learning system may train the intelligent data layer control tower 5820 ingestion processing control algorithm(s) to, for example, adjust (e.g., increase) the minimum window of time between ingestion events from a data source based on a degree of change in intelligence derived from data ingested from the data source. This learning may reduce ingestion events, ingestion frequency and the like, which can lead to reduced operation costs, while maintaining at least a minimum level of confidence in the derived intelligence. This information may be relayed on to a corresponding consumer, such as consumer X 5810 where ingestion frequency information may be used to further optimize or benefit use of the derived intelligence.

Referring to FIG. 58, an intelligent data layer is depicted as a data strategic approach for an enterprise. The intelligent data layer of FIG. 58 may include several elements that may have commonality with other embodiments herein, such as, without limitation an ingestion pipeline stage 5912, an analysis pipeline stage 5914, an intelligence pipeline stage 5916, an intelligent data layer control tower 5924. While these and corresponding intelligent data layer elements from other embodiments have similarity, there may be some differences that are generally described below.

Overall, a data strategic approach for an enterprise as depicted in FIG. 58 may facilitate deriving intelligence from a plurality of enterprise-specific data sources each with optionally distinct ontologies for meeting data-based intelligence needs and preferences for a plurality of enterprise entities (e.g., department, specific user, user role type, and the like), while taking into consideration enterprise goals, such as goals that are aligned across enterprise entities. Such an intelligent data layer may further facilitate compliance with security requirements, such as user/role-based restrictions on data exposure. One substantive advantage of such a data strategic approach is that intelligence may be derived from sources of data to which a given consumer of the intelligence (e.g., a department, employee, contractor, and the like) does not have access permissions. Another benefit of such a data strategic approach for an enterprise is harmonization of disparate data source ontologies through use of source-specific ingestion and/or analysis metadata. This harmonization may facilitate deriving intelligence from substantively distinct data sources using, for example, a common understanding of some aspects of the data sources. An example may include text data stored in different languages may be harmonized to a preferred common language that may be used for analysis, deriving intelligence, and the like. Many other examples are evident, such as different time zones for different entities of an enterprise, different currencies, and the like.

In embodiments, an ingestion pipeline stage facility 5912 may, using one or more of the exemplary techniques for ingestion of data from one or more data sources described herein ingest data from portions of an enterprise, such as individual departments, business units, field offices, subsidiaries, and the like. These enterprise-centric data sources may be referred to herein as department sources 5902. As noted above, data ontologies, formats, structures, units, and the like may vary from one department source 5902 (e.g., sales) to another (e.g., engineering). The ingestion stage 5912 may be constructed and/or configured to process data ingested from different department sources 5902 using corresponding ingestion parameters that may be updated/utilized on per department source ingestion-event basis. For example, when data is ingested from an engineering department source, ingestion control parameters (e.g., data ingestion rates, content definitions, and the like) associated with the engineering department source may be utilized by ingestion stage 5912 algorithms, circuitry and the like. When ingestion is performed from a sales department source, the ingestion stage 5912 algorithms, circuitry and the like may be adjusted (e.g., reconfigured) to enable ingestion of sales department data. In embodiments, the intelligent data layer control tower 5924 may configure the relevant portions of the ingestion stage 5912 based on the specific department source 5902 from which data is to be ingested. Further, the intelligent data layer control tower 5924 may adapt its internal control of ingestion stage 5912 resources (e.g., computing elements, data communication elements, and the like) based on an indication of one of the department sources 5902 from which data is to be ingested.

In embodiments, the intelligent data layer as a data strategic approach for an enterprise of FIG. 58 may interface with a variety of types of data sources, such as department data sources 5902 described above, on-demand sources 5920 that may be similar to on-demand sources 5818 of the embodiments of FIG. 57, and at least channels, such as periodic report channels 5918 that may be similar to the channels ID-316 of the embodiments of FIG. 57. As noted above not all aspects of the data sources of FIG. 58 (department sources 5902, channel periodic reports 5918, and on-demand source(s) 5920) include all of the functions and features of corresponding elements in other embodiments, such as the corresponding element depicted in FIG. 57 (e.g., sources 5802, channels 5816, and on-demand sources 5818 respectively). An exemplary enterprise embodiment may include periodic reports channels 5918 that are comparable to periodic enterprise reports. Examples include, daily updates of MRP systems, hourly updates of cash flow, weekly sales reports, quarterly profit/loss reports and the like. These examples depict only a few of the wide range of enterprise-specific data sources embodied as the periodic report data sources 5918. Others include without limitation, start/stop of shift production records, quality control periodic reports (e.g., coordinated with production activities), and the like. These data sources may produce updates of data on a periodic basis for use by the intelligent data layer intelligence derivation pipeline. As an example of periodic channel data sourcing, sales figures for each region may be updated and processed by a business data processing system of the enterprise each day between 3 and 5 AM to produce daily sales reports (e.g., by region, sales office, per salesperson, enterprise wide and the like). The intelligent data layer may ingest data from a corresponding periodic report at, for example 5 AM for processing through the intelligence pipeline so that intelligence derived from sales data can be delivered (e.g., published, and the like) as a general broadcast for access by a plurality of intelligence consumers of the enterprise and/or delivered to specific intelligence consumers of the enterprise (e.g., specific department/role, such as role X 5906 and the like). As described herein, ingestion through the ingestion stage 5912 may further based on detecting an indication of newly available data from a data source, such as a periodic report data source 5918. This may exemplarily be performed by a function of the ingestion stage 5912 that samples a port of one or more data sources of the enterprise, for an indication of new data availability. When such an indication is detected, ingestion may commence and/or the intelligent data layer control tower 5924 may be notified, such as through an API of the control tower and the like.

In embodiments, the intelligent data layer control tower 5924 may receive an indication of available ingestion data and initiate an ingestion sequence of events that may include optionally interfacing with one or more intelligence consumers (e.g., depart/role X, Y, Z) for authorization to perform ingestion from the indicated source. Such a sequence may be useful when the corresponding data source (and/or an operator/owner thereof) requires payment (e.g., receiving a credit to an account and the like) when ingestion is performed. In this way, a consumer of intelligence derived from the available ingestion data source (based on the indication of new source data) may optionally authorize or decline performance of the ingestion. The intelligent data layer control tower 5924 may include these and other factors when controlling the layer resources for functions such as ingestion and the like. The intelligent data layer control tower 5924 may further manage ingestion based in an indication of newly available source data by taking into consideration other uses of the source data. As an example, even when a source of data charges a fee for access of its data, the intelligent data layer may ingest the data independent of an authorization by a target intelligence consumer. In this example, the intelligent data layer may be configured to derive and publish intelligence for consumption by intelligence consumers of the enterprise for each indication of available data from a data source and subsequently debit an account of an intelligence consumer (e.g., a budget of department X) for a portion of the ingestion fee when the intelligence consumer receives/accesses the derived intelligence.

Another type of data source for an embodiment of an intelligent data layer as a data strategic approach for an enterprise may be an on-demand source 5920. In embodiments, such an on-demand data source 5920 may be comparable to the on-demand data source 5818 of the embodiments of FIG. 57.

In embodiments, operation of stages along a data intelligence deriving pipeline of the intelligent data layer of FIG. 58 may be influenced by enterprise aligned goals 5904. These goals may be embodied as business rules that may be applied during processing of data in one or more of the stages of the pipeline. As an example, a business rule 5904 for ingestion may indicate that ingestion from some sources should be performed only during non-peak times (e.g., not during regular business hours, not during a time when end of the data reports are being uploaded and the like). Such a business rule may impact ingestion from a corresponding source by adjusting a time of day when ingestion is performed, or a rate of ingestion to avoid overloading the data source during its peak time. Another exemplary enterprise aligned goal 5904 may include performing analysis of ingested data only after adjusting the ingested data for compliance with a data record structure (e.g., number of decimal places). The analysis stage 5914 may react to such a goal by first adjusting data records received from the ingestion stage 5912 to comply with this goal and then performing one or more analysis functions. Another exemplary enterprise aligned goal 5904 that may influence handing of data by one or more of the intelligence derivation pipeline stages may include use of a minimum number of different data sources when deriving some types of intelligence. This may be exemplified by adapting one or more intelligence derivation algorithms to be processed by the intelligence stage 5916 to ensure inclusion of the minimum number of data sources. Another exemplary aligned goal 5904 may specify a maximum amount of historical data to be factored when deriving intelligence. This may be embodied as a maximum number of days of historical data, maximum number of historical ingestion cycles, and the like. Yet another exemplary enterprise aligned goal 5904 for control of the intelligence derivation pipeline stages of an enterprise embodiment is use of artificial intelligence during processing of data. While a specific intelligence algorithm may not impose a constraint to use artificial intelligence, the algorithm may be adapted to use artificial intelligence (e.g., machine learning and the like) based on the aligned goal.

An intelligent data layer control tower 5924 may configure and/or adapt an on-demand ingestion process, such as ingesting data from on-demand sources 5920, based on user-related instructions, preferences and the like. Users of the platform may be users associated with an enterprise for which the Intelligent data layer control tower is configured. The tower 5924 may include an interface to a set of on demand user credentials 5922 that may be referenced when responding to user requests for ingestion and other operations of the system. In embodiments, the user credentials 5922 may inform access privileges and rights for individual users to effect on-demand ingestion and other intelligent data layer functions. In embodiments, the user credentials 5922 may be used to identify specific configurations and/or ingestion activities associated with certain users, certain types of users, certain user roles, and the like. On-demand user credentials 5922 may inform ingestion activities, scheduling, and the like. In an exemplary use of user credentials 5922 the intelligent data layer control tower 5924 may utilize aspects of user credential content to facilitate prioritizing use of on-demand ingestion resources. In this example, a production supervisor may request use of the ingestion capabilities of the system for validating employee payroll contemporaneously with a benefits team looking for benefit cost-trends. In example embodiments, the production supervisor, represented by an entry in an on-demand user credentials data store 5922 may, for this specific request, be designated as having higher priority access to the IDL framework resources than the benefits team member due at least in part to a relationship of the supervisor activity (payroll) to the benefits team member activity (research). This may result in the IDL control tower 5924 organizing the resources of the system to meet the supervisor's information needs ahead of the benefits team member's information needs.

Activities of an intelligent data layer, such as the intelligent data layer depicted in FIG. 58, may further be adapted based on one or more set of rules associated with the layer, such as layer rules for one or more departments, roles, and the like as may be depicted by layer rules 5926. Layer rules 5926 may influence a wide range of layer operations including ingestion, data sourcing, analysis, intelligence derivation, generation of out feeds, use of machine learning, and the like. Layer rules 5926 for a specific department may be prioritized over user-specific layer constraints that may be derived from user credentials 5922. Similarly, enterprise aligned goals that may be embodied as one or more sets of business rules 5904 may be prioritized over department and/or role-associated layer rules 5926. When these and other various sources of rules and the like that may influence an organization, activities, and functionality of the intelligent data layer conflict, such prioritization of rules (e.g., business rules rule over department rules that rule over user credentials, and the like) may be employed by the intelligent data layer control tower 5924 to resolve conflicts.

In example embodiments, an intelligent data layer control tower 5924 may apply department layer rules 5926 when configuring and/or operating an ingestion facility 5912 for handling data sources, such as source of an enterprise for various departments 5902. A department layer rule 5926 may be configured to inform the intelligent data layer regarding limitations of use of data sourced from department X. Such a set of rules may indicate that data from department X is not available for use by members of department Y unless authorized to do so by an authorization agent, such as a supervisor or owner of access rights to department X data. Another such set of rules may indicate that summary data for department X (but not details that contribute to summarizing the data, such as specific entries in department X data, or summarization rules, and the like) may be used freely by any enterprise user with access credentials (5922) that permit use of the intelligent data layer.

In addition to department layer rules 5926 may include role-specific or role-associated data layer rules. Data layer rules associated with a role may be for one or more types of roles in an enterprise (e.g., all human resources personnel, human resource managers, human resource executives, all executives independent of department, and the like). Data layer rules for roles may include rules associated with external roles, such as vendors, regulators, business partners, affiliates, subsidiaries, competitors, smart contract systems, automated transaction systems, and the like. External role data rules may influence a range of operations and data access services available to external users. As an example, a marketplace may use an intelligent data layer to provide access to marketplace data (e.g., activities of the marketplace, financials, and the like). The marketplace may configure an automated transaction system role layer rule that enables access to a subset of the marketplace information, such as transaction type and price, but not participants in the transaction, settlement terms among the participants, and the like. While personally identifying information is one example of information that may not be exposed to certain external roles by a marketplace, the example above suggests that there is a wide range of other, potentially valuable information that may be harvested from marketplace activity that operators (and/or participants) of the marketplace may deem to be excluded from access by external transaction automation systems, for example. Layer rules 5926 may be enforced by the intelligent data layer control tower 5924 in a variety of ways including, without limitation, adapting ingestion services (e.g., ingesting only a subset of information available from a source, limiting a rate or quantity of on-demand ingestion, and the like), applying filters and the like during analysis operations 5914 (e.g., to control generation of analysis outcomes, such as by rounding results to fewer decimal places, removing some results outside of a designated range or timeframe, and the like), adapting intelligence derivation functions (e.g., providing trending content, but avoiding predictions based thereon), and the like.

An intelligent data layer 5900 may include and/or have access to artificial intelligence services, such as machine learning services to enhance, among other things, handling of configuration parameters, such as ingestion parameters, data weights and the like that impact operations of the pipeline stages. These intelligence services may be provided by an intelligence data layer of an enterprise and/or platform with which the IDL is associated. In a converged transactions platform embodiment, configured intelligence services, such as those provided through an intelligence service controller and/or adapted artificial intelligence modules and the like may provide access to a wide range of intelligence and learning capabilities. Therefore, machine learning 5824 may be more fully described by and embody aspects of such configured intelligence services (e.g., as may be provided by a converged transactions platform, a network platform, and the like). In an example, a machine learning/feedback system 5928 may facilitate processing feedback, such as results of deriving intelligence via the intelligence stage 5916, data analysis outcomes via the analysis stage 5914, ingestion processing (e.g., data parsing and the like) via the ingestion stage 5912 and the like. In an example of machine learning-enabled feedback utilization, a set of consumption parameters (e.g., including a minimum window of time after ingestion of data from a data source 5902, channel 5918, or on-demand source 5920) may be adapted based on learning from outcomes of intelligence derived from the ingested data. The feedback may facilitate identifying an impact on the derived intelligence based on an amount of time since last ingestion from the data source. A machine learning system may train the intelligent data layer control tower 5924 ingestion processing control algorithm(s) to, for example, adjust (e.g., increase) the minimum window of time between ingestion events from a data source based on a degree of change in intelligence derived from data ingested from the data source. This learning may reduce ingestion events, ingestion frequency and the like, which can lead to reduced operation costs, while maintaining at least a minimum level of confidence in the derived intelligence. This information may be relayed to a corresponding consumer, such as consumer X 5906 where ingestion frequency information may be used to further optimize or benefit use of the derived intelligence.

In example embodiments, intelligent data layers may include or be associated with a comprehensive data collection and handling system that may be configured with dozens (hundreds, thousands, millions) of probes deployed in data networks, at data sources, listening on many content channels. Each probe may be tunable to “hear” certain types of content, specific content, variances in content, occurrence of events, and the like. In example embodiments, a set of probes may be configured (individually or in groups) to monitor a plurality of news sources for breaking news, such as financial news and the like that may indicate one or more changes to intelligence provided by one or more data layers that relies on financial news, for example. Each probe may individually, or in groups signal one or more intelligent data layer control towers to activate ingestion actions. In example embodiments, intelligent data layer probes may listen to data sources, data users (e.g., consumers/subscribers of data layer intelligence outputs), markets, transactions, and the like.

Referring to FIG. 59, an embodiment of an intelligent data layer combined with remotely deployed intelligence data layer probes is depicted. In general, remotely deployed probes may facilitate dynamic on-demand operation of one or more intelligence data layer functions. Further in embodiments, the intelligence data layer system of FIG. 59 may be embodied as a distributed intelligence data layer where operations, such as ingestion, analysis, and intelligence gathering may be disposed at a plurality of locations, such as at sources of data, at intermediate network components, such as edge computing, on one or more mobile intelligent data layer systems, and the like.

Intelligence data layer pipeline 6004 may include one or more data processing devices, processors, functions, algorithms, and the like as may be described herein for performing, among other things, ingestion from data sources, analysis of ingested source data, and intelligence derivation. Although not described in detail for this exemplary embodiment, aspects of the intelligence data layer pipeline 6004 may be substantially similar to comparable aspects in embodiments herein, such as without limitation the ingestion, analysis, and intelligence services of the enterprise intelligent data layer of FIG. 58, the ingestion, analysis, and intelligence services of the unaffiliated intelligent data layer of FIG. 57, and similar facilities and services of the exemplary intelligent data layer of FIG. 56.

Intelligence data layer probes, such as source probes 6010 may be configured to monitor aspects of sources of data, such as data set states (e.g., for updates and/or other changes or transactions associated with such data sets), data producing or modifying activities of a data source, such as business workflows, transaction systems, and the like, data access factors, such as changes to requirements (e.g., authorization) for accessing one or more sources of data, time-related triggers for data sources (e.g., early release of an update, delayed release of an update, an announcement of new sources, and the like). In a further example of source probes 6010, a probe may be configured to monitor transaction activity in a marketplace against a threshold (transaction counts, rates, value, assets, and the like). When the monitored activity detected by the probe exceeds (or fails to meet) a threshold, one or more corresponding intelligent data layers maybe activated to take an action, such as ingesting data, marking data as out-of-date, and the like.

In example embodiments, source probes 6010 may be configured to aggregate probe monitoring results. As an example, a plurality of source probes 6010 deployed to monitor traffic within a city or other region may collaborate to enable compound trigger conditions, such as to notice changes in traffic patterns that indicate changes in commuting activity. This may include one or more of the probes communicating together to determine that, due to an unmonitored activity (e.g., a traffic jam due to a sink hold), traffic counts in certain roadways are different than typical, for example. In another example, a plurality of source probes may be configured to monitor smart contracts associated with a product or service. These source probes may be deployed with or as part of the product or service and therefore may be dispersed across a geographic region (e.g., across a target market for the product/service). Although these probes may be disparately distributed, the probes may be configured/adapted to aggregate monitoring activity and provide one or more signals to one or more intelligent data layers when the aggregated monitoring indicates a need for action, such as ingestion of data from sources associated with the probes.

In example embodiments, social media probes 6016 may be configured to monitor a variety of social media-centric data, activities, events, and the like. In example embodiments, a social media probe 6016 may be deployed to monitor activity associated with a new product release. A social media probe 6016 may be deployed by a social media creator/influencer to monitor for mentions of his/her name or other identity based on a set of criteria, such as mentions in association with a topic of interest to the creator.

One or more intelligent data layer monitoring probes may be associated with consumption parameters 6022. Such parameter probe 6020 may be configured and/or adapted to monitor consumption parameter activity, such as to detect, for example, changes in one or more consumption parameters. In embodiments, data consumers may indicate, such as through configuration of the consumption parameters 6022 and the like specific channel(s) of data from which, for example intelligence is desired, or from which data is required for processing in one or more of the intelligent data layer processing pipeline stages based on, for example, configuration data for a consumer-specific instance of the intelligent data layer. A consumption parameter probe 6020 may detect such consumer activity and activate one or more processes of the intelligent data layer accordingly. An intelligent data layer consumer, such as data consumer X may indicate that a channel that delivers a stream of transactions within or for an institution or marketplace as a channel source of data from which or in association with which the data consumer desires derived intelligence. As an example, a buyer associated with a transaction marketplace, may desire to be informed, such as through use of the methods and systems of intelligence data layers described herein, of intelligence to be derived from a stream of transaction outcomes provided on a secondary marketplace channel (that may include activation of a channel probe). In this example, an intelligent data layer control tower 6028 may respond to a trigger or other indication by the parameters probe 6020 by processing consumption parameters 6022 to configure a schedule for listening to secondary market transaction outcomes. The consumption parameters for consumer X may, in this example also define one or more of ingestion and/or analysis, and/or derived intelligence algorithms and/or processes to be applied when processing those outcomes along the pipeline (as streamed, in batch or the like as may be specified in, for example, the consumption parameters 6022 for consumer X) via ingestion, analysis, and intelligence derivation. In embodiments, data channels 6012 may also publish data according to a publication schedule. An intelligent data layer control tower 6028 may coordinate the consumption parameters 6022 with each channel's publication schedule so that the ingestion stage connects with a channel that corresponds to the consumption parameters 6022 contemporaneous with the scheduled publication time as may be influenced by a channel probe 6026. In example embodiments, a consumption and parameter probe 6020 may monitor an impact of activity by a machine learning and feedback facility 6024 that may provide feedback, such as suggested changes in consumption parameters and the like.

In example embodiments, consumption probes 6006 may be configured for each of a plurality of intelligence data layer consumers 6008. Consumer probes 6006 may be configured with and/or integrated into one or more aspects of a consumer system, such as an interface between the consumer 6008 and the intelligent data layer 6004. A consumer probe 6006 may monitor, for example, consumer interactions with and uses of data sourced from one or more intelligent data layers. In example embodiments, a single consumer probe 6006 may be configured to notify a plurality of intelligent data layers when certain consumer activity is observed, such as when a consumer accesses data downloaded from the intelligent data layer. A single consumer probe 6006 may be configured with a plurality of monitoring settings to facilitate monitoring a plurality of conditions at a consumer that may be of interest to one or more intelligent data layers. In an example, a first intelligent data layer may provide intelligence and data to a first consumer associated with the first consumer's role as a purchaser in a marketplace. A second intelligent data layer may provide intelligence and/or data to the first consumer associated with the first consumer's role as a seller in a second marketplace. A single consumer probe 6006 may be configured to monitor the first consumer's activities in association with content provided by both the first and second intelligent data layers. The single consumer probe 6006 may signal to the first intelligent data layer based on a first set of monitoring conditions associated therewith and may signal to the second data layer based on a second set of monitoring conditions associated therewith.

In example embodiments, intelligent data layer probes may be configured, activated, deactivated, adapted, and the like through actions of an intelligent data layer control capability such as the intelligent data layer control tower 6028, such as control tower 5924, 5820, 5712 described herein. Actions of an intelligent data layer control tower 6028 that impact one or more deployed probes may be activated by one or more other probes. In example embodiments, a social media probe 6016 may identify activity (e.g., negative reviews) associated with a product (e.g., a health care device) from a particular source (e.g., device manufacturer) in a pool of sources 6002. The identified activity may cause the social media probe 6016 to activate a control tower of a corresponding intelligent data layer to take an action. The control tower 6028 may determine that one such action may include activating a probe that monitors one or more data sources (e.g., purchasing, shipments, customer support activity, and the like) of the device manufacturer. In example embodiments, the control tower may respond to the identified activity by adapting an ingestion scope associated with the corresponding source of data, such as adapting a schedule of ingestion, and the like.

In example embodiments, probes may be activated, distributed, reconfigured, aggregated, triggered for monitoring, and the like based on other activities of the intelligent data layer, such as corresponding ingestion schedules, changes in consumption requirements, parameters, based on machine-learning enabled feedback and the like. As an example, a change in consumption parameters for a source of data to which a source probe is deployed may cause a change in, for example monitoring threshold for data elements being monitored by the source probe. A consumption parameter of a user of the intelligent data layer may deemphasize content coming from a specific source. A source probe associated with the specific source may be reconfigured to monitor for changes that impact a higher percentage (e.g., 20%) of the source data as compared to detecting changes to as little as 5% of the source data prior to the changes in the consumption parameters to deemphasize the source. In another example of operations of the intelligent data layer impacting probe configuration, machine learning may recommend monitoring for changes on a more frequent basis than the frequency of current monitoring. An intelligent data layer control tower may adjust a deployed probe, and/or deploy a replacement probe to perform monitoring more frequently. I this example, a second probe may be deployed that monitors data at the same rate as the first probe but on a different cycle, thereby effectively doubling the monitoring rate. The first and second probes may further be adapted to aggregate their results when determining if an intelligent data layer activation threshold is met.

In example embodiments, a source of data may set a price for use of data provided from the source. Pricing of source data may be a factor that source probes may be configured to monitor. An intelligent data layer control tower may configure a source probe to monitor a price for the data that may trigger ingestion of data from the source. In example embodiments, the source probe may be configured with a compound set of monitoring criteria, such as a target price and an availability window of time that matches one or more consumer criteria of the intelligent data layer.

Operation of one or more intelligent data layers may include and/or be based at least in part on an understanding of relative values of aspects of source data to both a data source provider and an intelligent data layer output consumer. A data producer, such as a marketplace transaction platform, may assign a high value to format of certain content being produced, such as using a streaming format for transaction data. An intelligent data layer consumer may choose to obfuscate the format, focusing instead on timing of certain types of data being produced by the marketplace transaction platform, such as for detecting trading rates and the like. A data producer (e.g., a data source as described herein) may deem that timeliness of data delivery has a substantive impact on a value (e.g., a cost to access the data). For example, data that represents recent activities of the marketplace transaction platform may be priced higher than data representing aged (e.g., historic) activity. A consumer may deem that recent market activity may be less valuable due to the market's dynamic nature, whereas data from prior transaction sessions, now fully settled for example, may represent more stable and therefore more valuable.

The value mapping structure 6102 embodied in FIG. 60 may facilitate developing and/or documenting such understanding of value to producers and consumers. A producer 6104 may consider aspects of data being produced, such as data format(s) 6106, data content 6108, a meaning of the content 6110, a cost of the data 6112, and the like. A consumer 6114 may consider aspects of data used by an intelligent data layer to provide data ingestion, analysis, and intelligence services for the consumer, such as a value of the data 6116, format(s) of the data 6118, timing of the data 6120, and meaning of the data 6122, and the like. Intersections indicated in FIG. 60 between producer aspects and consumer aspects may be populated with one or more values, algorithms, functions, references and the like (e.g., intersection content). Such intersection content may be embodied into one or more functions of a corresponding intelligent data layer. As an example, an intersection of a producer meaning 6110 with a consumer value 6116 may enable applying a consumer's perception of value to one or more meanings of data that may be defined by the producer. In this example, a producer may define a meaning of a set of source data to mean an error rate in surgical procedures that require re-admittance. A consumer, such as an insurer may determine that data with this meaning imputes a high value to the consumer, such as for setting reimbursement to a facility. A higher rate of error that results in readmittance (e.g., with 48 hours and/or based on a determination that the surgical error prompted the readmittance) may be used by the intelligent data layer consumer to withhold reimbursements for certain surgical procedures for a time period that exceeds a likelihood of a patient returning to the hospital due to the error (e.g., at least 48 hours post-surgery). The withhold threshold may be configured into a source probe at the surgical facility that monitors admittances so that when a readmittance occurs, the intelligent data layer may be activated to process the readmittance data for the insurer.

Another example of mapping producer perception of aspect value to consumer valuation may include ascribing a consumer meaning 6122 for a cost of collection 6112 required by a producer. In example embodiments, such a meaning may be within a context of understanding of the consumer. In this example, a consumer may deem that a low cost of collection for certain data maps to a higher tactical/decision meaning than that same low collection cost data means for long-term adjustment to ongoing operations. In another example, a meaning of certain data to a consumer may suggest that the producer demand a higher value than would otherwise be acceptable based on the producer's collection cost of the data. In this example, an intelligent data layer control tower may implement the consumer's meaning as requiring frequent updates by ingesting data from the source frequently. The frequent updates may result in relatively small changes to ingested content. In this context, the intelligent data layer control tower may negotiate a lower cost for each ingestion with the data producer due to the small amount of new data being produced.

Yet another example of mapping producer perception of aspects of sourced data to consumer perception may include determining a relationship between consumer perceived value 6116 and a producer's collection costs 6112. As in the example above, a consumer may highly value certain data from a producer that has a relatively low collection cost. In example embodiments, a producer may set a price for sourcing data that is inconsistent with a consumer's perceived value thereof. A control tower for an intelligent data layer may respond to a determination of this inconsistency by cancelling a scheduled ingestion of the source data, automatically negotiating with the producer for a price that may reflect the consumer perceived value, seeking other sources of data that provide comparable consumer value at lower price, and the like. The control tower may determine this inconsistency by detecting that a consumer-provided content in an intersection of producer cost 6112 and consumer value 6116 reflects this inconsistency. In example embodiments, this inconsistency may include detecting producer cost data in the intersection that may be high compared to other collection costs coupled with a consumer value data that may be low compared to other consumer value entries for other source data, and the like. Further, a consumer may provide a function that enables the control tower to determine this inconsistency by, for example, the consumer may provide target cost data that would be acceptable for use of the producer data. In this example the consumer may provide a maximum target cost data, a target cost with an automatic escalation clause (that maybe administered by a smart contract between the consumer and the intelligent data layer entity), a cost per unit of time (e.g., a maximum amount to be allocated by the intelligent data layer control tower to use of the source of data per day, week, month, and the like).

In yet another example of intelligent data layer operation based on a mapping of provider and consumer perspectives may include operation based on a mapping of a provider perspective of available content 6108 with a consumer perspective on timing of the content 6120. In this example, a consumer may desire access through the intelligent data layer to content, such as content provided by data source X. However, the consumer may identify a timing of use of the content, such as based on a point in time (e.g., an upcoming or recently occurred event), based on a duration of time (e.g., content availability must meet a time-frame condition), and the like. When the desired content X is available outside of the time constraint, the consumer entity may elect to not use the content. Further in this example, a consumer entity may configure a trial period for end users to access intelligence that the consumer derives through the intelligent data layer based at least in part on content X. When an end user activates a trial, the consumer may signal to the intelligent data layer, such as through adjustment of the consumer timing parameter 6120 for the source content 6108 to make use of content X during the trial period. Once the trial period expires, the intelligent data layer may pause ingestion of content X until activated to do so again. In another content-time mapping example, a provider may signal that content is available for use other than between time X and time Y (e.g., outside of a blackout period, such as a blackout period associated with a live sporting event and the like). The consumer that is interested in this access time-constrained content may designate in a representative map 6102 that the content can be used by the intelligent data layer for a duration of time (e.g., a business day) commencing at time Y. In this way, only content that is made available by the source soon after the blackout window would be ingested by the intelligent data layer for use in producing intelligent data layer content (e.g., intelligence derived therefrom) for the consumer.

In example embodiments, an intelligent data layer control tower may use artificial intelligence functions, such as intelligence services that may be provided by a platform (e.g., a transaction marketplace platform and/or system of systems, a control tower platform and/or system of systems, and the like, to determine a set of operating criteria for each of a plurality of users (e.g., consumer entities) of the intelligent data layer based on analysis of the mapped producer and consumer parameters of parameter map 6102. In example embodiments, an intelligent data layer control tower may have access to a plurality of such maps 6102. As an example, each consumer of the intelligence data layer may be associated with a map.

In example embodiments, an intelligent data layer may learn (e.g., through use of machine learning and the like) configurations of MAP 6102 that may be valuable to one or more candidate consumers. Learning may be based on a plurality of consumer-configured maps 6102. Learning may be based on consumer utilization of data sources, optionally combined with consumer configuration parameters, such as consumption parameters 6022 and the like. The intelligent data layer control tower may speculatively configure the intelligent data layer to produce outputs (e.g., intelligence and the like) based on the learnings of consumer use and mapping 6102 and may offer/market/publish set of data based on the speculative configuration. In example embodiments, an intelligent data layer control tower and/or intelligent data layer entity may publish/market/advertise/offer one or more learned configurations for use by other intelligent data layer entities, such as through a licensing scheme and the like.

Intelligent data layers may be configured to operate in cooperation with enterprise systems. In example embodiments, enterprise systems may include a plurality of modules, such as for distinct departments, subsidiaries, and the like that may benefit from intelligent exchange of information. An intelligent data layer may facilitate information exchange combined with at least entity-specific intelligence that may improve utility and value of information gathered and/or used in such modules. In example embodiments, one or more such modules may include distinct processing systems, locally and/or remotely deployed, and communicating through one or more networks, such as an intranet, an internet, and the like. In example embodiments, an enterprise may include a networked chain of value-contributing entities, such as participants in a supply chain and the like. In example embodiments, a plurality of intelligent data layers may be configured for an entity to achieve one or more objectives of information sharing.

Referring to FIG. 61, embodiments of methods and systems for intelligent data layers implementing entity data-centric strategies are depicted. Enterprises, such as businesses, government agencies, educational institutions, religious institutions, networks of entities, and the like may include a plurality of participants in a data-centric strategy 6210 for the enterprise. Data centric strategy participants may include a range of sub-entities, divisions, departments, bureaus, subsidiaries, locations, franchises, and the like. For simplicity in the exemplary embodiments of FIG. 61, a department 6202 is depicted to represent any and all such participants. While a department of an enterprise may generally be thought of as integral to the enterprise, a department 6202 may not be so constrained; a department 6202 be a separate enterprise in one or more potentially loose and/or transient associations with an enterprise for which the department 6202 is a participant in a data-centric strategy 6210 for the enterprise. Examples may include, two competitive enterprises that have optionally entered an agreement for information sharing associated with a third competitor, a new market, international relations, and the like. A department, such as department 6202 may be distinguished for entity data-centric strategy purposes from external sources merely based on a degree of participation in the strategy. As an example, external sources of data that may provide information, such as external intelligent data layers and the like, that is useful for achieving a successful data-centric strategy, may usefully be differentiated from a department 6202.

In the embodiments of FIG. 61, a department 6202 may receive data from one or more sources, including enterprise-internal sources and other sources. A department 6202 may subscribe to and/or receive information from one or more external intelligence data layers 6204. A department 6202 may be a consumer of information (e.g., data and derived/related intelligence) from the external intelligent data layer 6204. The department 6202 may be a producer of data for one or more external intelligent data layers. Sources of data for a department 6202 may include any such sources disclosed herein, including, for example, one or more data feeds 6206. The department 6202 may participate in an entity data-centric strategy 6210 via one or more internal intelligent data layers through which data, intelligence, and the like may be exchanged. As an example of an internal intelligent data layer between a department 6202 and an entity data-centric strategy 6210, a department may publish content for the strategy that is processed with an input intelligent data layer 6208. The internal intelligent data layer 6208 may be embodied as and/or may include any functionality of any of the intelligent data layers described herein. In an example, an input intelligent data layer 6208 may operate with the department 6202 as a data source and with the strategy 6210 as a consumer thereof.

An example of an internal intelligent data layer between the department 6202 and the strategy 6210 may include an output intelligent data layer 6214 that may operate with the enterprise strategy 6210 as a source of data and the department 6202 as a consumer of the layer 6214.

While a single department 6202 and singular input and output intelligent data layers 6208 and 6214 respectively are depicted in the embodiments of FIG. 61, any number of departments, and any number of input and output intelligent data layers may be configured for achieving an entity data-centric strategy 6210. A single department may generate a plurality of different types of data that may be useful to the entity strategy and processed through a plurality of distinct intelligent data layers. Likewise, a department may consume data from a plurality of intelligent data layers as may be configured for publishing data associated with the strategy. Further although depicted as distinct input and output intelligent data layers, any data layer may operate bidirectionally. Each intelligent data layer, such as 6208 and 6214 may be configured to process and/or provide compound layer intelligence and the like.

A data-centric strategy 6210 may be configured to handle data sharing needs for an enterprise. The data-centric strategy 6210 may include subsets of data associated with operations of the enterprise that are stored locally, such as in the localized data store 6216. A localized data store 6216 may be configured as a single storage facility, a set of distributed storage facilities distributed throughout the organization and connected physically and/or logically through one or more networks, such as an internet, an intranet, and the like. A data centric strategy 6210 may further interface with cloud-based data stores 6212, such as to store data useful and/or pertinent to operation of workflows of the enterprise, including data and intelligence captured from external sources through one or more intelligent data layers, data and intelligence generated in the course of executing workflows of one or more portions of the enterprise, such as the department 6202, data and intelligence produced through one or more intelligent data layers of the enterprise and the like. In example embodiments, a data-centric strategy service of an enterprise may include a cloud-based data store management capability that, among other things, maintains freshness of data and/or intelligence that may be used by one or more portions of the enterprise, such as for performing one or more workflows, and the like. In an example, a set of intelligence content that may be stored in the cloud-based data store 6212 may include strategic pricing predictions for the enterprise. These pricing predictions may be dependent on a range of enterprise-internal data as well as external information, such as fuel costs, shipping costs, currency exchange rates, and the like. In this example the data-centric strategy service may maintain a currency of such pricing prediction intelligence by capturing, such as through intelligent data layers, relevant content including, without limitation, current fuel costs, light crude futures, regional fuel costs, shipping capacity and demand data, shipping costs from contracts with shippers, and the like.

The specifics of how an organization chooses to locally store data may inform structural constraints of one or more intelligent data layers of the enterprise. As an example, an intelligent data layer that accesses locally stored data associated with enterprise from a plurality of distributed data stores may include a plurality of ingestion services that may be tuned to retrieve data from distinct data sources. In example embodiments, ingestion services of intelligent data layers that work cooperative to provide a data-centric strategy for an enterprise may be configured and operated similarly to ingestion services of intelligent data layers described elsewhere herein, such as ingestion services of intelligent data layer 6004 of the exemplary probe-enabled intelligent data layer of FIG. 59, ingestion facility 5912 of the exemplary strategic approach for an enterprise of FIG. 58, ingestion system 5804 of the exemplary independent data layer of 260, ingestion function 5704 of exemplary intelligent data layer architecture of FIG. 56, and the like.

Each intelligent data layer of an architecture to provide data sharing for achieving a data-centric strategy for an enterprise may be configured with a control tower configured to operate the corresponding data layer. An enterprise may be configured with one or more interconnected control towers (not depicted in FIG. 61) that facilitate control of one or more of the intelligent data layers, such as by coordinating operation of the distinct intelligent data layer control towers and/or by controlling one or more of the intelligent data layers independent of a presence of a control tower for a corresponding intelligent data layer.

In the exemplary embodiments of FIG. 61, a data-centric strategy 6210 may employ one or more external intelligent data layer handling facilities 6218 for facilitating use of external intelligent data layers, such as layers that may provide data and/or intelligence based on data from sets of sources that are external to the enterprise. As an example, an industry consortium may operate one or more intelligent data layers that offer industry-impacting data and intelligence to consortium members, and the like. Such an external intelligent data layer may support customized data and/or intelligence production upon request. The external intelligence data layer controller 6218 may adapt requests 6222 that may satisfy one or more data/intelligence needs of the strategy 6210 to configure an external intelligent data layer-specific request.

The external intelligent data layer controller 6218 may be configured to handle a plurality of differently configured external intelligent data layers. Such a plurality of external data layers 6220 may be depicted in FIG. 61 as IDL-EX, IDL-EY, and IDL-EZ. External intelligent data layer IDL-EX may provide data/intelligence based on operations of a supply chain to which the enterprise may be a participant. External intelligent data layer IDL-EY may provide intelligence on consumer buying trends for one or more products/services of the enterprise. External intelligent data layer IDL-EZ may provide data/intelligence on marketplace transactions that may carry products of the enterprise and/or products that are similar to and/or compete with products of the enterprise.

The external intelligent data layer controller 6218 may provide a programmatic interface between external intelligent data layers 6220 and the enterprise strategy 6210, to facilitate, among other things, consolidation of external data layer data/intelligence into a single, optionally composite enterprise input intelligent data layer IDL-EI. The controller 6218 may be configured to make a portion of the plurality of external intelligent data layers to appear to the enterprise as a single intelligent data layer, optionally with composite and/or compound operation. As an example of this capability of the controller 6218, the enterprise strategy may form a request 6222 for data that may not be directly available from a single external intelligent data layer. The controller 6218 may identify relevant potential external sources to satisfy the request 6218, such as a combination of two external intelligent data layers 6220. In this example, the controller may parse the request, thereby revealing that the request includes a first type or domain of data/intelligence (e.g., operations of a network) that may be provided by a first external intelligent data layer (e.g., IDL-EX). Parsing the request may further reveal that a second type or domain of data in the request (e.g., consumer buying trends for one or more products/services of the enterprise) may be provided by a second external intelligent data layer (e.g., IDL-EY). In example embodiments, the controller 6218 may establish a consumer-type relationship with the two external intelligent data layers to receive data and/or intelligence that may satisfy at least the two types of data in the request. The controller may further make at least a portion of the information from the two external intelligent data layers available for use in achieving the entity data-centric strategy 6210. The controller may make the information available by consolidating information it consumes from the two external intelligent data layers into a consolidated data set for use by the entity. The controller 6218 may configure the information consumed from the two external intelligent data layers into a compound intelligent data layer for consumption and use in the data-centric strategy 6210.

Referring to FIG. 62, a configuration of intelligent data layers forming a set of networked data sharing interfaces among a plurality of systems, internet-of-things devices, and the like is depicted. Intelligent data layers may be configured with interfaces that facilitate sharing of data among entities to achieve a wide variety of data sharing services and capabilities. Intelligent data layers may be interfaced with each other to form intelligent networks and/or content channels with one or more physical networks that provide not only raw data transfer capabilities, but also provide delivery and sharing of content and intelligence arranged for a specific consumer, need, or other criteria.

Data sources, such as internet-of-things devices may have limited processing capacity, and or may be configured for purpose-specific operation (e.g., a data sensor and the like). While the information provided by these devices may be rich in a context of its deployment, without the context the information may be less valuable. As an example, a data sensor that puts out a stream of temperature readings may provide valuable and accurate temperature information. However, by itself, this information may be hard to appreciate. Such as what is the temperature information indicative of? Two otherwise identical engines may produce substantively different core lubricant temperatures, such as based on a context of the deployment of the engine. One of the engines may be deployed in an environmentally protective box on a line pole in the Caribbean (thereby indicating a temperature at or near the maximum permitted) and the other may be operating above the arctic circle in winter (thereby indicating a temperature well below the maximum). Merely providing raw temperature sensor data would likely not be sufficient for deriving much intelligence about the engine. However, when the sensed engine temperature is combined with, for example sensed ambient temperature, the resulting intelligence value may be high. By interfacing intelligent data layers, such as exemplarily depicted in FIG. 62, a richness of knowledge and intelligence may result, including increasing available information through combined intelligence services.

The networked intelligent data layers depicted in FIG. 62 facilitate intelligent data sharing among a first IoT device IoTY 6302, a second IoT device IOTZ 6304, a first system, system Z 6306, and a second system, system A 6308. In example embodiments, the networked architecture of FIG. 62 may facilitate transfer of intelligence from the two IoT devices to a first system 6306 and further, optionally incorporating intelligence and/or data produced by the first system 6306 into a set of intelligent data layers consumed by the second system 6308.

Each of IoTZ and IoTY may combine inputs, such as inputs A and B for IoTY and inputs C and D for IoTX to each produce a pair of intelligent data layers, IDL-YA and IDL-YB, for IoTY and IDL-XC and IDL-XD for IoTX. Each of these four intelligent data layers may be combined in pairs to produce composite IoT intelligent data layers, IDL-IoTY for IoTY and IDL-IoTX for IoTX. Yet further, intelligent data layer IDL-IoTXY may be formed from outputs of intelligent data layers IDL-IoTX and IDL-IoTY. In example embodiments, any of these data layers may operate substantially similar to intelligent data layers described herein. As an example, intelligent data layer IDL-IoTX may provide one or more set of outputs, including data, intelligence and the like derived at least in part from information produced by intelligent data layers IDL-XC and IDL-XD. Intelligent data layers IDL-XC and IDL-XD may provide data and/or intelligence based on IoTX inputs C and D respectively. In an example, input C may monitor bidding activity for a marketplace including pricing of bids. Intelligent data layer IDL-XC may ingest and analyze the monitored bidding activity, and further may provide intelligence based on, for example changes in the monitored bidding activity. Input D may monitor settlement activity for completed transactions in the marketplace. Intelligent data layer IDL-XD may ingest and analyze the monitored settlement activity, and further may provide intelligence based on, for example trends in settlement terms. Intelligent data layer IDL-IoTX may ingest the bidding activity change intelligence from IDL-XC along with settlement terms trends from IDL-XD, (and optionally raw and/or analyzed source bidding activity and settlement terms from a corresponding intelligent data layer) to analyze these inputs and deliver intelligence, for example regarding relative impacts of changes in bidding activity on settlement terms as one of one or more outputs of IDL-IoTX.

Monitored information A and B of IoTY may be processed by intelligent data layers IDL-YA and IDL-YB. Outputs from these intelligent data layers may be further ingested and analyzed to produce at least intelligence based thereon by intelligent data layer IDL-IoTY.

A first joining intelligent data layer ILD-IoTXY in FIG. 62 may consume content from intelligent data layers IDL-IoTX and/or ILD-IoTY and deliver at least derived intelligence for consumption by system Z 6306. As an example, system Z may perform regulatory compliance validation for marketplaces being monitored by IoTY and IoTX. IDL-IoTXY may provide intelligence, raw transaction data, and/or analyzed transaction, marketplace, and financial data for a plurality of transactions in the monitored marketplace. System Z 6306 may apply transaction validation rules, such as rules derived from inputs E and F to generate a plurality of types of data, optionally as a set of intelligent data layers including IDL-ZE, IDL-ZF, and IDL-Z. In this example, system Z 6306 may produce intelligent data layer IDL-ZE that provides at least intelligence based on marketplace and/or transaction data derived from intelligent data layer IDL-IoTXY and input E. Likewise intelligent data layer IDL-ZF may provide raw and/or analyzed data and/or intelligence based on validation source data F and content from intelligent data layer IDL-IoTXY. System Z 6306 may further produce an intelligent data layer IDL-Z from native data sources, internal operations, inputs (e.g., E and/or F) and the like. Further, not all potential sources of data for use by system Z 6306 are depicted; however, other sources, including internal, external, and the like are contemplated as aspects of the embodiments of at least FIG. 62.

Further in the embodiments of FIG. 62, intelligent data layer IoTXYZ may be formed to facilitate access by other entities to data, and/or intelligence derived from one or more of IoT device IoTY 6302, device IoTX 6304, and system Z 6306 via intelligent data layer IDL-Z. In example embodiments, other entities that may consume intelligence and the like from intelligent data layer IoTXYZ may include system A 6308. In example embodiments, system A 6308 may further consume data and/or intelligence associated at least with system Z 6306 via intelligent data layer IDL-Z.

In example embodiments, system Z 6308 may ingest content from source G as well as one or both of intelligent data layers IDL-Z, and IDL-IoTXYZ. In some embodiments, system A 6308 may produce a first intelligent data layer IDL-AG that may be based on information consumed from source G. System A may also produce a second intelligent data layer IDL-AZG that may provide data and/or intelligence derived from source G and one or more of intelligent data layers IDL-Z and IDL-IoTXYZ.

The network of intelligent data layers depicted in FIG. 62 may facilitate access to intelligence provided by system A 6308 (e.g., through intelligent data layer IDL-AZG) that may take into consideration data and or intelligence derived throughout the network and being based on one or more of inputs E and F to system Z, inputs A and B to IoTY, and inputs C and D to IoTX.

Intelligent data layer architectures may include cloud-based variants. Exemplary embodiments of cloud-based intelligent data layers are depicted in FIG. 63. A cloud-based intelligent data layer may be embodied as an accessible service, such as a service available to the public for accessing intelligence from a range of data sources. In embodiments, the cloud-based intelligent data layer 6400 embodiment of FIG. 63 may operate independently to provide intelligence determination services for data consumers. This intelligent data layer may be provided as a service, (e.g., hired/rented/utilized) by a plurality of independent data consumers, such as through payment of a subscription fee, one-time use fee, and the like. In embodiments, the cloud-based intelligence data layer 6400 depicts a distributed set of entities for producing data for a plurality of data consumers. A micro-service architecture, such as described herein and elsewhere, may further enable isolated and independent processing throughout the layer operating pipeline for each consumer, such as by initiating a virtualized container to perform one or more of the intelligent data layer pipeline functions for each data consumer (e.g., consumer X, Y, Z). In an example, a virtualized container may be operated (e.g., on a cloud processing architecture that has low latency access to data being processed in the container). In embodiments, low latency access may include, without limitation, local access, such as a data processing server in a networked data storage facility and the like. A virtualized container may be configured with a consumer-specific instance of the ingestion server 6404. In this example, the consumer-specific instance of the ingestion server 6404 may be configured with consumer-specific ingestion parameters and/or functions, so as to, for example, listen to certain source data channels 6410 designated and/or selected when configuring the ingestion server instance for the consumer. In embodiments, an intelligence analysis server 6408 of an intelligent data layer pipeline of this intelligent data layer 6400 may be instantiated in, for example, a virtualized container environment. The instance may be configured with intelligence derivation algorithms associated with a specific consumer, such as data consumer Y 6420.

While data consumer-specific instances of pipeline services are described as possible embodiments for the cloud-based intelligent data layer 6400, other architectures are possible and contemplated herein. One such architecture includes abstracting (e.g., through use of virtualized containers, and the like) use of pipeline server functions that operate on one or more physical, logical, and/or virtual servers. In this example architecture, a core pipeline service may operate on a server with data for a plurality of data consumers being stored in a low-latency data storage facility. In this example embodiment, virtualization facilitates on-demand access to the computing capabilities of the server and more specifically to the computing capabilities and functions of a corresponding pipeline server, while isolating input data, in-process data, configuration data, and intelligence outcomes so that each consumer appears to have full access to the intelligent data layer based on their needs.

In yet another exemplary embodiment, a plurality of functions of the intelligent data layer may be instantiated within or associated with a virtualized container environment that may be dedicated to providing intelligence services to a specific data consumer or set of data consumers. In this way, ingestion, analysis, intelligence, control tower, storage, and publishing (e.g., producing a data and/or intelligence feed for the specific consumer) may be logically configured within a virtualized environment for providing intelligent data layer services independently of other consumers.

The embodiment of FIG. 63 may be differentiated from other embodiments, such as embodiments where an intelligent data layer is integrated into a data consumer (or optionally a data supplier) computing environment, such as embodiments depicted in FIG. 63 and FIG. 58.

Data layer processing elements, such as ingestion server 6404, analysis server 6406, and intelligence derivation server 6408 may, for purposes of disclosure efficiency, be substantially, although not exhaustively, as described in corresponding elements 5704, 5706, and 5708 from FIG. 56 respectively. Further, some features of a corresponding stage in FIG. 56 may, in embodiments, be configured differently or excluded from a corresponding server in FIG. 63. As an example, the ingestion stage 5704 may include data conversion capabilities that may be excluded from embodiments of the ingestion server 6404, at least for instances where those capabilities are not needed, such as when an instance of the ingestion server 6404 is ingesting data from a source for which at least some types of data conversion are not required.

In embodiments, ingestion server 6404 may, in addition to interfacing with data sources 6402 (that may be, for purpose of compact disclosure, substantially, although not exhaustively, as described in corresponding element 5702 from FIG. 56) may further interface with data channels 6410 and on-demand data sources 6412. The data channels 6410 may be serviced by an ingestion server, using, for example, a channel listening function that may be controlled by and/or integrated with intelligent data layer control tower 6414. In embodiments, data consumers may indicate, such as through configuration of the consumption parameters 6416 and the like specific channel(s) of data from which, for example intelligence is desired, or from which data is required for processing in one or more of the intelligent data layer processing pipeline operations based on, for example, configuration data for a consumer-specific instance of the intelligent data layer. A data consumer, such as data consumer X 6418 may indicate that a channel that delivers a stream of transactions within or for an institution or marketplace as a channel source of data from which or in association with which the data consumer desires derived intelligence. As an example, a buyer associated with a transaction marketplace, may desire to be informed, such as through use of the methods and systems of intelligence data layers described herein, of intelligence to be derived from a stream of transaction outcomes provided on a secondary marketplace channel. In this example, the intelligent data layer control tower 6414 may process consumption parameters 6416 to configure a schedule for listening to secondary market transaction outcomes. The consumption parameters for consumer X may, in this example also define one or more of ingestion and/or analysis, and/or derived intelligence algorithms and/or processes to be applied when processing those outcomes along the pipeline (as streamed, in batch or the like as may be specified in, for example, the consumption parameters 6416 for consumer X 6418) via the ingestion server 6404, the analysis server 6406, and the intelligence server 6408. In embodiments, data channels 6410 may also publish data according to a publication schedule. The intelligent data layer control tower 6414 may coordinate the consumption parameters 6416 with each channel's publication schedule so that the ingestion server 6404 connects with a channel that corresponds to the consumption parameters 6416 contemporaneous with the scheduled publication time. In an example, an instance of the ingestion server 6404 may be configured to begin listening for data from a specific channel or channels before or at a start of a scheduled publication. Alternatively, the ingestion server 6404 may be configured and/or activated to begin listening at a point in time relative to the start of scheduled publication, such as after a preamble of the publication, at an initiation of publication of detailed data values, at or near to an end of publication of detailed data values, or after a configurable number of publication steps, and the like.

As noted elsewhere herein intelligence may be derived from source content, structure, and metadata, among other things. In embodiments, intelligence associated with a data channel 6410 may be derived based at least in part on the respective channel's publication schedule. One example of intelligence that may be based on a publication schedule includes awareness of timing of potential changes in data from the channel. Therefore, changes in resulting intelligence may be adapted based on the schedule, such as indicating that intelligence derived prior to a new data publication schedule may be deemed to be “aged” (e.g., weighted lower than more updated intelligence and the like). Time-based averaging of data from such a source may be synchronized with its publication schedule.

As noted herein, another potential source of data may include on-demand data sources 6412. Unlike channels of data, such as data channels 6410 that may publish data on a schedule or based on events or the like, an on-demand data source 6412 may be controlled, such as by the intelligent data layer control tower 6414 to generate (e.g., publish or make available) data when requested. An on-demand data source 6412 may include devices that “sleep” by activating a lower power mode in between requests (demands) for data. While depicted as individual entities, data sources that provide channels 6410 and data sources that provide on-demand data 6412 may not be distinct. A single data source may provide a plurality of data interfaces, including in this example an on-demand interface and a publication channel interface.

The cloud-based intelligent data layer 6400 may include a configuration data storage facility 6416 that may include, among other things, consumption parameter storage for each of a plurality of clients/consumers/users of the layer 6400, such as consumer X 6418, consumer Y 6420 and/or consumer Z 6422 and the like. In embodiments, layer configuration data for a data consumer may be stored separately from the parameter storage 6416 and may be accessed through, for example, a link to the separate configuration data in the parameter storage 6416. Configuration parameter storage facility 6416 (e.g., that may be virtualized and the like) may be configured with data consumer distinct portions to facilitate isolation between users of the layer 6400. A type of configuration parameter that may be accessible in or through the configuration parameter storage facility 6416 may include ingestion parameters, such as for facilitate control of ingestion activities by, for example, the intelligent data layer control tower 6414, an instance (e.g., in a virtualized container) of the ingestion server 6404 and the like.

The layer configuration storage facility 6416 may be accessed by a data consumer of the data layer 6400 through various computer-to-computer protocols, including networked storage protocols, streaming protocols, indirect access protocols (e.g., through a proxy service that provides access to the storage) and the like.

In the exemplary embodiment of FIG. 63, configuration data may include information that facilitates ingestion (e.g., data sources and ingestion controls), analysis (e.g., data source processing, data source relationships, and the like), intelligence (e.g., intelligence algorithms, and/or identification of third-party intelligence services to be used when processing data for the consumer) and the like.

A cloud-based intelligent data layer 6400 may include and/or have access to artificial intelligence services, such as machine learning services to enhance, among other things, handling of configuration parameters, such as ingestion parameters, data weights and the like that impact operations of the pipeline. In embodiments, machine learning 6424 may facilitate processing feedback, such as results of deriving intelligence via the intelligence server 6408, data analysis outcomes via the analysis server 6406, ingestion processing (e.g., data parsing and the like) via the ingestion server 6404 and the like. In an example of machine learning-enabled feedback utilization, a set of consumption parameters (e.g., including a minimum window of time after ingestion of data from a data source 6402) may be adapted based on learning from outcomes of intelligence derived from the ingested data. The feedback may facilitate identifying an impact on the derived intelligence based on an amount of time since last ingestion from the data source. A machine learning system may train the intelligent data layer control tower 6414 ingestion processing control algorithm(s) to, for example, adjust (e.g., increase) the minimum window of time between ingestion events from a data source based on a degree of change in intelligence derived from data ingested from the data source. This learning may reduce ingestion events, ingestion frequency and the like, which can lead to reduced operation costs, while maintaining at least a minimum level of confidence in the derived intelligence. This information may be relayed on to a corresponding consumer, such as consumer X 6418 where ingestion frequency information may be used to further optimize or benefit use of the derived intelligence.

A cloud-based intelligent data layer architecture, such as architecture 6400 may include communicating information, such as sourced data, intelligence algorithms, intermediate results, results from each pipelined server through a network, such as the Internet. Further intelligent data layer controller 6414 may establish secure channels with and among various other servers of the cloud-based architecture through an Internet to facilitate content sharing, operational control security and the like.

In example embodiments, an ingestion server 6404 may communicate through the Internet and/or other public or private network with data sources, such as source devices 6402, source channel servers 6410, on-demand servers 6412, the internet, and the like to perform ingestion of data used to produce intelligence and the like. An analysis server 6406 may also communicate through the network, such as the Internet to capture, analyze and process content output from the ingestion server 6404. Intelligence server 6408 may interface with one or more other servers of the cloud-based intelligent data layer architecture 6400 through a network such as the Internet and the like. In example embodiments, consumer servers 6418, 6420, and 6422 may be constructed to operate on edge computing servers within the network that are proximal to a home computing system of each of the customers X, Y, and Z respectively.

In example embodiments of a cloud-based intelligent data layer 6400, a customer server, such as customer X server 6418 may optionally be configured to operate on customer X's home server, such as a server on an enterprise network for the customer X and the like. In this way, the aspects of a cloud-based intelligent data layer may be deployed on networked servers that may be proximal to source data and/or consumer computing devices, storage and the like.

Referring to FIG. 64, an embodiment of a multi-use intelligent data layer 5550 that may be used to produce different layer intelligence and content for different purposes across a plurality of intelligent data layer consumers. A multi-use intelligent data layer 5550 may employ an architecture that has some expected similarities with other intelligent data layer architectures described herein, such as a data processing set of stages, referred to herein, in embodiments, as data processing pipeline stages including one or more ingestion stages, one or more analysis stages, and one or more intelligence stages. Each such stage may be embodied as one or more sets of services that may be provided by one or more servers.

To facilitate dynamic multi-tenant use of the intelligent data layer 5550, at least a portion of the pipeline stages may be configured to receive and process data and corresponding parameters for performing its respective pipeline data operations. As an example, ingestion server 5556 may receive source content 5554 and source parameters 5552. One exemplary ingestion processing function includes parsing unstructured content, such as by applying a dictionary for determining relevance and/or meaning of data received from data sources. For such an exemplary ingestion operation, a set of source content 5550 may be received from a source and a corresponding parsing dictionary may be provided contemporaneously with the source content, such as in the form of one or more ingestion parameters 5552. The source parameters, such as a parsing dictionary may be received by the ingestion server 5556 in various forms, including one or more identifiers of corresponding parameters. As an example, a parsing dictionary for ingesting data from source X may be available to the ingestion server 5556 via a link that may be provided in association with source content 5554. The linked parsing dictionary may have been received by the ingestion facility (or via another interface to the intelligent data layer as may be described elsewhere), stored for later use and assigned a link to the stored dictionary that is matched to an identifier known to the ingestion server 5556 to be used for parsing content from source X. As content from source X is received the ingestion server 5556 may reference the stored dictionary via the link corresponding to source X for parsing source content from source X.

In example embodiments, ingestion server 5556 may receive content 5554 and parameters 5552 in association with an ingestion event or action. Ingestion server 5556 may be configured to receive a stream of data from a source Y for the ingestion event. The server may also receive, contemporaneously with this stream (e.g., at an initiation of the stream event) a set of ingestion parameters for processing content in the stream event from source Y. As an example, source parameters 5552 for a stream may include units of measure (e.g., kilometers/hour, percent of a volume, currency exchange rates, and the like) for data values included in the corresponding stream. The ingestion server 5556 may apply the units of measure to data values received in the stream to facilitate conformance of the data value with other content used by the intelligent data layer 5550.

The ingestion server 5556 may be configured to align source content 5554 and source parameters 5552 for each ingestion event during ingestion processing. This may allow the ingestion server 5556 to receive and maintain continuity of source content 5554 and source parameters 5552 from a plurality of sources for application to a plurality of intelligent data layer operations.

A multi-use intelligent data layer, such as intelligent data layer 5550 may further facilitate configuration of an ingestion server 5556 to accommodate a plurality of ingestion scenarios, such as distinct sources, distinct ingestion activities for each source and/or a plurality of intelligent data layer consumers, and the like. In example embodiments, one or more sets of ingestion control parameters 5668 may be created, configured and/or maintained by one or more operation and control processes of the intelligent data layer. Sets of ingestion control parameters may be associated with consumers of the intelligent data layer to facilitate ingestion operations that meet data and intelligence needs of the consumers. As described herein, a consumer may identify ingestion data sources, ingestion schedules, ingestion triggers for on-demand ingestion, and the like. Sets of consumer-specific ingestion parameters may be referenced by a control system for ingestion, such as a control system of the ingestion server 5556 to align ingestion operations with consumer expectations, layer needs, and the like.

The ingestion server 5556 may provide ingested content, optionally including one or more parameters (or information derived therefrom) to use by a data analysis server 5558. The ingestion server 5556 may apply a source-specific dictionary to a set of ingested data to produce a multi-dimensional output that includes data processed with the dictionary and analysis parameters that apply to the ingested content. As an example, a set of ingestion event and/or source-specific analysis parameters derived during ingestion may include information pertinent to a degree of accuracy of the ingested content, such as a number of decimals to which the source content is rounded during ingestion. Other analysis parameters that may be passed from an ingestion server to an analysis server may include ingestion timing related parameters, such as a start and stop date/time for a set of ingested content being forwarded to the analysis server 5558.

Other exemplary embodiments, capabilities, features, services, aspects, functions, constructions, implementations, and variations that may be included with and/or incorporated into ingestion server 5556 may be described in association with ingestion stage 5704, ingestion stage 5804, and ingestion stage 5912.

The analysis server 5558 of the multi-use intelligent data layer 5550 may perform various operations on a result of ingestion server 5556 parsing and other ingestion activity based on a range of factors, such as comparing data from a plurality of sources for similarity, fitness to a purpose, differences, based on types of data within or across data sources and the like. In embodiments, analysis may include comparing sources against a target use of intelligence derived from a data source. Analysis of ingestion results may attempt to determine if one or more data elements from a data source may meet consumption target requirements, such as meeting a validity time constraint, an accuracy constraint, a frequency of update constraint, relevance to a consumption subject matter focus, and the like. In embodiments, the multi-use intelligent data layer 5550 may target providing intelligence for a plurality of distinct buyers of services in a software orchestrated transaction marketplace. The analysis server 5558 may determine if one or more data elements from sources of content 5554 may be relevant for generating intelligence about the marketplace services and based on the results of analysis may indicate to a controller (e.g., a control tower as described herein and the like) for the layer to utilize the source content (e.g., data) for generating derived intelligence. The multi-use intelligent data layer 5550 may publish or otherwise convey requests for content, such as types of data, and the like that one or more content sources 5554 may attempt to meet. The analysis server 5558 may determine if ingested content meets requirements of the published request for data, such as if the content complies with one or more parameters in the request.

In embodiments, the analysis server 5558 may facilitate configuring data in the layer for publication, such as configuring one or more advertisements that characterize the ingested data in terms of potential intelligence value, relevance and the like. Examples include making data, such as derived intelligence data available on a marketplace (e.g., configuring indexing schemes and the like), making the content searchable (e.g., identifying keywords, terms, values, or the like that may facilitate discovery of intelligence derived from the ingested data through use of a search capability. The analysis server 5558 may facilitate access visibility to information of the intelligent data layer 5550 by publishing, communicating, or broadcasting samples of the data over a network, directly to potential consumers and the like. In embodiments, potential consumers of intelligent data layer intelligence and services may include other intelligent data layers, existing value supply chain participants, transaction marketplace participants, and the like.

In embodiments, the analysis server 5558 may suggest, predict, and/or estimate value of ingested data for a plurality of different consumers. These estimates may be used by the control tower to impact intelligent data layer functions, such as IDL intelligence pricing and the like that may be differentiated for different users. Further such analysis may indicate that intelligence derived from a first data source may be more or less valuable to different target consumers.

The analysis server 5558 may use feedback from intelligent data layer users regarding, among other things, usefulness of intelligence derived from one or more data sources to facilitate ingestion and analysis activities and the like. In an example, positive feedback on intelligence derived from a data source may result in communication from the analysis server 5558 to a controller to make use of the data source for deriving other types of intelligence and the like. Feedback handled by the analysis server 5558 may include feedback from uses of similar data, such as use of data from different sources that may be determined to be similar. In an example, positive feedback regarding use of a data from a first data source may trigger the publishing requests for similar data. Feedback handled by the analysis server 5558 may be based on similar intelligent data layers. Feedback handled by the analysis server 5558 may be based on alternate configurations of the multi-use intelligent data layer 5550 that may be activated to provide intelligence services for different consumers.

In embodiments, distinct configurations of the multi-use intelligent data layer 5550 may collaborate to meet data consumer needs, such as cross market transaction environments and the like. An analysis server 5558 configuration for a first use (e.g., for producing market intelligence for a product market) may collaborate with an analysis server 5558 configuration for a second use (e.g., for producing market intelligence for a service market). In embodiments, collaboration across configurations of a multi-use intelligent data layer 5550 may be enabled through exchange of data, such as by a first collaborating configuration of the analysis server 5558 producing analysis results that are provided as a data source for a second configuration of the multi-use intelligent data layer 5550.

In embodiments, the analysis server 5558 may include and/or be configured as a set of analysis algorithms that may execute on one or more processors. These one or more processors may comprise a controller for the intelligent data layer 5550, such as intelligent data layer control tower 5712 depicted and described in association with FIG. 56.

The analysis server 5558 may communicate ingested data, results of analysis, information received from an ingestion stage 5556, and the like to an intelligence server 5564. Results of analysis may include, without limitation, analyzed content 5562, analyzed ingestion and/or analysis parameters 5560, and the like. The analysis server 5558 may receive and analyze parameters received from the ingestion server 5556. This analysis may include adapting, summarizing, reconfiguring, prioritizing, decoding, encoding, filtering, and other types of analysis processes thereby producing a set of analyzed parameters 5560 that may coordinate with analyzed content 5562.

An intelligence server 5564 may provide intelligence services, such as for deriving intelligence associated with and/or based on information received from analysis server 5558 (e.g., analyzed content 5562, and the like). The intelligence server 5564 may utilize artificial intelligence capabilities to develop an understanding about data sources including, among things, uses of data, values of data, applicability of data, collection patterns and relevance to intelligence consumption and the like. Additional intelligence that may be derived by intelligence server 5564 may include, without limitation, layer configuration specific data relevance, relevance of data from one configuration of the multi-use intelligent data layer to another configuration, value of intelligence to a consumer, such as to a transactor, network participant or supply chain participant, transaction marketplace participant and the like. In an example, intelligence server 5564 may derive intelligence useful for forming new marketplaces from transactional data gathered from an existing marketplace.

In embodiments, the intelligence server 5564 may be in communication with the intelligent applications 5576. The intelligence applications 5576 may communicate intelligence algorithms, configuration data (e.g., sets of data that enable the intelligence server 5564 to perform various intelligence functions) and the like to the intelligence server 5564 as well as control various aspects of activity of the intelligence server 5564. In embodiments, the intelligence server 5564 may execute one or more of the intelligence algorithms on one or more processors.

The intelligence apps 5576 may be organized to align with individual consumers of the layer so that the intelligence server 5564 may be configured to perform intelligence functions designed to deliver the type and form of intelligence consistent with consumer expectations. In example embodiments, a first intelligence application of the set of intelligence applications 5576 may be configured to work cooperatively with a first set of ingestion control parameters of the plurality of sets of ingestion control parameters 5568 (and optionally a first set of analysis configuration parameters) that, cooperatively configure the intelligent data layer 5550 to ingest, analyze, and derive intelligence to meet data intelligence needs of a consumer, such as consumer X of the set of consumers 5566.

In example embodiments, the intelligence server 5564 may be embodied as one or more intelligence services available from sets of configured intelligence services available for use through a network system of systems and/or an autonomous market orchestration system of systems, and the like. Further each set of intelligence applications of the plurality of sets of intelligence applications 5576 may be embodied as one or more of the configured intelligence services described herein. To make use of such embodied intelligence applications, the multi-use intelligent data layer 5550, such as through programmatic interface variant of the intelligence server 5564 may communicate with intelligence functions of one of the exemplary system of systems described herein. In embodiments, the intelligence server 5564 and at least a portion of the plurality of sets of intelligence apps 5576 may be embodied as one or more intelligence services of such system of systems architectures, including without limitations one or more adapted artificial intelligence modules.

In example embodiments, the multi-use intelligent data layer 5550 may include one or more interfaces 5572 for initiating and/or controlling production of intelligent data layer content for consumers, such as the plurality of consumers 5566. Such an IDL interface 5572 may provide a user interface 5570 through which a user may configure and/or adjust configurations and operations of various portions of the multi-use intelligent data layer 5550. In an example, a user may review candidate data sources as may be suggested by the analysis server 5558 and the like. User review of such candidate data sources may result in acceptance of the source for use by the layer, rejection of the source, or conditional acceptance that is determined during operation of the layer, such as based on consumer ingestion control parameters and the like. The user interface 5570 may provide a wide range of user access, control, and monitoring activities, such as monitoring utilization of the aspects of the multi-use intelligent data layer 5550, configuring access parameters for consumers, responding to requests by consumers for intelligence functions and the like.

The IDL interface 5572 may facilitate interactions between a user and layer aspects, such as ingestion control parameters 5568, ingestion server 5556, analysis server 5558, intelligence server 5564, intelligence applications 5576 and the like. The IDL interface 5572 may further provide a programmatic interface between aspects of the layer with robotic process automation capabilities 5574. In example embodiments, robotic process automation capabilities 5574 may be utilized to automate development of new operational configurations to provide intelligence for new consumers and the like. The robotic process automation capabilities 5574 may identify activities used to configure a plurality of configurations of the layer, determine relevance of such activities to producing certain types of intelligence and the like to facilitate generating automated configuration sets to meet requirements of new consumers and the like. In a robotic process automation example, configuration steps by a user to configure ingestion control parameters, identify preferred content sources, configure the analysis server, actions for arranging intelligence services including configuring intelligence applications and the like for a plurality of consumers may be analyzed by the robotic process automation capabilities to determine at least a recommended sequence of actions to meet intelligent data layer configuration requirements for a new consumer. Likewise, actions that may result in identification and/or validation of new content sources may be automated via robotic process automation.

Intelligent data layers may be configured to provide integral information services to marketplace platforms, such as system of system transaction architectures, transaction environments, and the like to deliver, among other things a high degree of intelligence for market participants and marketplace systems (e.g., including marketplace automation systems, software orchestrated transactions, marketplace owners, and the like). Marketplace platforms may publish intelligent data layers based on marketplace activity. Marketplace platforms may subscribe to intelligent data layers derived from information sources, such as market-centric sources, competitive sources, buyer and seller sources, government and regulatory sources, and a wide range of sources that may be made available for consumption. Buyers and sellers may subscribe to intelligent data layer-based information sources, that support each marketplace platform participant's role. As a buyer participant example, intelligent data layers for buyers may gather and synthesize pricing trends, alternative sellers and offerings (e.g., other products or services) and costs through aggregating data from several sources. As a seller participant example, intelligent data layers for sellers may improve value of a seller's offering to a buyer, revenue to a seller, such as add-ons, cross-market offerings, etc. Financing terms can each be represented by intelligent data layers that supply curated, synthesized data to a seller to facilitate offers, counteroffers, financing options, access to funding, and the like. As a market maker participant example, intelligent data layers may gather and synthesize market impacting data to help, for example, with establishing a companion market in a foreign jurisdiction for a local (regional, national, etc.) market, and the like.

Referring to FIG. 65, an intelligence-enabled marketplace deployment of intelligent data layers is depicted. A marketplace platform 5652 may subscribe to intelligent data layers of market-centric content 5666, such as marketplace regulating sources, marketplace operational sources, such as smart contracts that may impact automating transactions, companion marketplace platform content (e.g., trade and terms information from companion marketplaces and the like), third-party informational services, such as marketplace item curators, item authenticators, and the like. In an example, marketplace platform 5652 may subscribe to an intelligent data layer IDL-MIA (market intelligence input layer A) that may capture transaction-related data from a plurality of marketplaces, such as market pricing data, transaction cost data, and the like. In the example, the marketplace platform 5652 may also subscribe to an intelligent data layer IDL-MIB (market intelligence input layer B) that may capture, analyze, and derive intelligence from after-market activity associated with participants and/or products and services for which the platform 5652 provides transaction services. A set of intelligence services of the platform 5652, such as one or more Configured Intelligence Services described here (e.g., risk analysis intelligence services, machine learning services, digital twin services, and the like) may process information (e.g., raw data, analyzed data, derived intelligence) provided from these market-centric intelligent data layers (5666) to perform various marketplace platform functions, such as transaction cost optimization, regulatory compliance, cross-market service offerings (e.g., for after-market type activity, such as product customization, archival packaging and the like).

In example embodiments, a marketplace platform 5652 may generate a wide range of transaction-related information and may employ intelligent data layers to gain value from this information through, for example, offering preconfigured and/or configurable intelligent data layers to provide data intelligence services based on the generated data. For exemplary purposes, the embodiments of FIG. 65 include a first marketplace platform output data layer IDL-MOA that may be configured to provide optimized and/or include intelligence 5670 suitable for use by marketplace buyers 5654. The marketplace platform 5652 may further include a second marketplace platform output data layer IDL-MON that may be configured to provide optimized for an/or include intelligence 5672 suitable for use by marketplace sellers 5656. The marketplace platform 5652 may yet further include a plurality of marketplace platform output data layers (e.g., IDL-MOB, and the like) that may offer to third-parties actionable information and intelligence about the platform and optionally about transactions occurring on the platform. In an example, after-market service providers (e.g., extended warranty and the like) may subscribed to a third-party oriented intelligent data layer to detect transaction information useful for providing extended warranty (or other) services. Third-party oriented intelligence provided through such an intelligent data layer may include information that goes beyond transaction outcomes, such as seller offer trends (which products are sellers more likely to be offering), buyer trends (what types of products are buyers coming to the platform looking to purchase), correlations between ingested market-centric intelligence (e.g., third-party services being provided to buyer/seller participants of the platform) and platform transaction metadata (e.g., costs of transactions, financing of transactions), and the like.

A marketplace platform, such as platform 5652 may be integrated into and/or be associated with an automated market orchestration system of systems as described herein. The marketplace platform 5652 may rely on intelligence and other services of the automated market orchestration system of systems to provide output intelligence data layers, such as third-party relevant intelligence data layer IDL-MOB, through analysis and intelligence derivation from one or more sources of marketplace platform information. To produce, for example, a seller-centric output intelligent data layer IDL-MOA, the platform 5652 may interface with an intelligence module controller and related intelligence services (e.g., machine learning, robotic process automation and the like) to harvest, analyze, and derive seller-related information services that can be consumed by seller participants 5656 of the platform marketplace 5652. Seller-focused intelligence data layer, such as IDL-MON that produces seller intelligence 5672 may be useful to improve value of a seller's offering to a buyer, increase revenue to a seller, such as through inclusion of add-ons, enable cross-market offerings among sellers, and the like.

Market platform participants may include sellers 5656 and buyers 5654. Participants may subscribe to intelligent data layers to facilitate their participation in the marketplace, such as by getting advanced information and intelligence about items relevant to them. A seller 5656 may subscribe to a plurality of seller-centric data sources 5662 through a plurality of intelligent data layers 5664. These seller-centric intelligent data layers 5664 may be configured and/or include features and capabilities of intelligent data layers described herein, such as, without limitation 5700 of the embodiments of FIG. 56.

Seller entities, such as seller computing systems and the like may interface with one or more of these seller intelligent data layers through programmatic computer-to-computer interfaces, such as Application Programming Interfaces and the like, including those described in association with intelligent data layers described herein, such as the API 5606 of intelligent data layer 5604 of the embodiments of FIG. 55. Seller entities 5656 may subscribe to or otherwise access content from the seller-centric intelligent data layers 5664 similarly to intelligent data layer consumers described herein, including without limitation consumers 6008 of the embodiments of FIG. 59. Seller intelligent data layers 5664 may be configured as described herein to meet one or more information and/or intelligence needs, desires, interests, priorities, preferences, and the like of one or more sellers 5656. A seller intelligent data layer of the set of intelligent data layers 5664 may be configured to provide real-time intelligence and information regarding currency exchange rates (e.g., cross-national currencies, cryptocurrencies, and the like) that may facilitate use of analytics and the like by a seller entity to adapt transaction pricing, parameters, and the like. As an example, if a current exchange rate suggests potentially greater value to a seller who makes those transactions today, the seller may adjust terms of items in the marketplace, offering a bonus (e.g., lower price, extra services, free item) for buyers who perform an instant payment transaction and/or increases costs to a buyer who defers payment transaction into the future.

A buyer 5654 may subscribe to a plurality of buyer-centric data sources 5658 through a plurality of intelligent data layers 5660. These buyer-centric intelligent data layers 5660 may be configured and/or include features and capabilities of intelligent data layers described herein, such as, without limitation 5700 of the embodiments of FIG. 56.

Buyer entities, such as buyer computing systems and the like may interface with one or more of these buyer intelligent data layers through programmatic computer-to-computer interfaces, such as Application Programming Interfaces and the like, including those described in association with intelligent data layers described herein, such as the API 5606 of intelligent data layer 5604 of the embodiments of FIG. 55. Buyer entities 5654 may subscribe to or otherwise access content from the buyer-centric intelligent data layers 5660 similarly to intelligent data layer consumers described herein, including without limitation consumers 6008 of the embodiments of FIG. 59. Buyer intelligent data layers 5660 may be configured as described herein to meet one or more information and/or intelligence needs, desires, interests, priorities, preferences, and the like of one or more buyers 5654. A buyer intelligent data layer of the set of intelligent data layers 5660 may be configured to provide real-time intelligence and information to a buyer of the set of corporate buyer entities 5654, such as changes in corporate strategy (e.g., acquisition/merger insight), updated corporate buying procedures (e.g., information and intelligence on how changes in buying procedures can best be reflected in current transaction activities), corporate sales outlook (e.g., to facilitate adjustments in delivery timing and deferral), cash flow of the corporation (e.g., ability to offer to pay cash and reduce pricing), available financing options (e.g., status of corporate lines of credit), and the like.

Buyers 5654 and sellers 5656 participants in the marketplace platform 5652 may benefit from marketplace contextual updates. However, buyers in the set of marketplace buyers 5654 and sellers in the set of marketplace sellers 5656 may develop independent a marketplace context consumer profiles that maybe configured into a marketplace intelligent data layers IDL-MFB (buyer) and IDL-MFS (seller). In example embodiments, marketplace contextual information 5670 from a marketplace output intelligent data layer IDL-MOA may be adapted by a first instance of the buyer intelligent data layer IDL-MFB for a first buyer (e.g., a corporate buyer) and may be adapted differently (at least in part) by a second instance of the buyer intelligent data layer IDL-MFB for a second buyer (e.g., a non-profit buyer) to enrich an experience and/or performance of each such buyer in the set of buyer participants 5654. Likewise, marketplace contextual information 5672 from a marketplace output intelligent data layer IDL-MON may be adapted by a first instance of the seller intelligent data layer IDL-MFS for a first seller (e.g., a corporate seller) and may be adapted differently (at least in part) by a second instance of the seller intelligent data layer IDL-MFB for a second seller (e.g., a non-profit seller) to enrich an experience and/or performance of each such seller in the set of seller participants 5656.

Intelligent data layers may play a role in developing new sources of content for enriching utility, value, and relevance of the types and extend intelligence that these layers provide. Source discovery, vetting, and integration are among a plurality of services and capabilities intelligent data layers may provide. The embodiments depicted in FIG. 66 may include intelligent data layer source discovery. An intelligent data layer control tower 5762 may be configured with and/or include access to artificial intelligence capabilities including machine learning and the like. When an intelligent data layer 5750 with the intelligent data layer control tower 5762 depicted in FIG. 66 is deployed with and/or integrated into a marketplace system of systems, such as an automated market orchestration system of systems described herein (and/or optionally a network) an array of intelligence services may be made available for use in source discovery and the like.

The intelligent data layer control tower 5762 may be configured to configure, operate, and optimize execution of source discovery functions, such as an ingestion capability server 5756, an analysis server 5758, and the like. In an example of source discovery, the intelligent data layer control tower 5762 may direct the ingestion server 5756 to capture information from and/or about candidate sources 5752. In this example, the control tower 5762 may direct an advertising function of the ingestion server 5756 to advertise one or more requests for content that may be useful to the intelligent data layer 5750. The ingestion server 5756 may contact a plurality of known content sources with sets of criteria that may be descriptive of a type of content desired. The ingestion server 5756 may explore, e.g., through web crawling, crowd sourcing and the like, potential sources of data that may comply with the sets of criteria. In example embodiments, the ingestion server 5756 may identify a set of criteria that is descriptive of a current data source used by the intelligent data layer 5750. The ingestion server 5756 may adapt the criteria (e.g., adjust a range of descriptive value, broaden the criteria by abstracting one or more requirements, vary presence of different aspects of the criteria) and seek for potential sources of new content.

The intelligent data layer control tower 5762 may use artificial intelligence to develop suggestions for source content criteria, such as based on analysis of existing sources, based on requests for variation of intelligence from consumers of the intelligent data layer, feedback relating to usefulness of existing sources, and the like. These developed suggestions may further include references to source meta data, such as data format, unit of measure, jurisdiction, access criteria, access costs, content availability, content use terms, and the like. Using any of a range of content discovery methods, including those described herein, the ingestion server 5756 may capture content from one or more candidate sources 5752 that may meet at least a portion of the source discovery criteria. In an example, the ingestion server 5756 may be tasked with capturing content from mobile devices associated with an enterprise, such as mobile phones configured to interface through secure means (e.g., a virtual private network) with external sources. In another example, the ingestion server may adapt an ingestion profile for one or more existing sources, such as to permit ingestion of content that may have been excluded from ingestion under the original ingestion profile.

Data collected from candidate sources 5752 via the ingestion server 5756 may be vetted for compliance with at least a portion of a target new content ingestion criteria, such as complying with a data format, a language, a minimum precision, and the like. The ingestion server 5756 may pass (e.g., stream and/or store for separate access) acceptable content to the analysis server 5758. The ingestion server 5756 may also provide source discovery status information to the intelligent data layer control tower 5762, such as source location information (country, jurisdiction, URL, domain, and the like) at least for sources for which content has been passed along to the analysis server 5758. In example embodiments, the ingestion severs 5756 may maintain a list, directly and/or through interaction with the intelligent data layer control tower, of candidate sources accessed and their status. The ingestion server 5756 and optionally the intelligent data layer control tower 5762 may rely on this source status for future source discovery activity. As an example, if a result of widening an ingestion profile for an existing data source X results in little or no data that meets a minimum set of target source discovery criteria, then a record of the existing source X could be updated to reflect the relevance (or lack thereof) to the desired content. When another source discovery activity is performed, the source relevance records may be examined before seeking to pursue different content from this particular currently approved source.

In example embodiments, an analysis server 5758 may be configured to evaluate content ingested from a new candidate source for meeting one or more aspects of a target new data source discovery criteria. As an example, criteria for a new source may include consistency of terminology (content) in the source and optionally consistency of terminology to existing terminology used to process ingested content. In example embodiments, the analysis server 5758 may be artificial intelligence-enabled, which may facilitate use of various artificial intelligence analysis techniques. An example analysis may involve performing a recursive operation on data values to determine if the data approaches zero (indicating that the day may meet a stability criteria), or if the data does not exhibit a minimum degree of stability. The range of potential analysis techniques here are essentially unbounded; however, for any given analysis activity of a candidate source, it is likely that a set of criteria for a target use of the data may be used to identify a subset, optionally a small subset of analysis actions to take on the data.

For content that meets an acceptability criterion based on a result of analysis operations on the ingested candidate source data, additional candidate source data vetting steps may be applied. In the example embodiments of FIG. 66, similarity of such candidate source data to existing source data 5754 may be determined, such as via a similarity server 5760. The similarity server 5760 may evaluate new content source data against the existing source data 5754, potentially performing one or more comparisons to determine if the new content source data may provide a meaningful contribute to increase intelligence capabilities of the layer. In example embodiments, the similarity server 5760 may determine similarity of candidate source data by generating one or more values that capture at least one degree of similarity 5764. The similarity server 5760 may determine that data values in the candidate source may be too similar to existing sources and therefore may indicate that in the degree of similarity 5764. IN an example, an intelligent data pipeline may facilitate monitoring operation of an automated welding station. A candidate source of data may include additional temperature sensors on the station. If, upon analysis and similarity comparison, the candidate source temperature values add no substantive new information, the source may be deemed to be lacking in usefulness. For instance, the additional sensors provide a temperature of a welded piece immediately before welding. However, a current temperature sensor provides information that permits determining this indirectly because it reports an ambient temperature proximal to the piece to be welded, which suggests that temperature data from the candidate source(s) does not provide sufficient new information to meet the usefulness criteria.

Based on this degree of similarity 5764, an estimate of relevance and/or utility may be generated by a utility/relevance server 5766. The estimate of relevance may be expressed as a degree of usefulness 5768. An example degree of usefulness 5768 may include a predicted impact on intelligence that may be derived when data from the candidate source is used by one or more intelligence derivation algorithms, examples of which are described herein. If a degree of usefulness 5768 meets a usefulness criterion (e.g., facilitates generating intelligence based on new types of data sources), the intelligent data layer control tower 5762 may add the candidate source to a list of approved sources by issuing a source decision 5770. If the degree of usefulness 5768 does not meet the usefulness criteria, the intelligent data layer may issue a support decision 5770 that instructs the ingestion server 5756 to ignore the candidate source, at least temporarily for the current instance of source discovery. A candidate source may not meet usefulness criteria if, for example, intelligence results from use of the candidate source data are outside an acceptable range. As an example, intelligence derived from existing sources may include a desired range of trend values. If intelligence algorithms applied with the candidate source data results in generation of trend values outside of the desired range, the usefulness may fall short so that the candidate source may be excluded in the source decision 5770.

### Data and Networking Pipeline for Market Orchestration

Referring to FIG. 67, a block diagram of exemplary features, capabilities, and interfaces of an exemplary deployment environment 6700 of a data and network infrastructure pipeline 6704 is depicted. Data network and infrastructure pipelines may be configured as a portion (or portions) of one or more transaction platforms. The exemplary embodiment in FIG. 67 depicts a data network and infrastructure pipeline 6704 characterized with at least one each of a set of asset-centric intelligent network resources, a set of intermediate intelligent network resources, and a set of market-centric intelligent network resources (optionally including a set of asset entities, a set of marketplace entities, and associated controllers) interconnected for providing asset data and asset data-derived content (e.g., intelligence) from, for example one or more set of assets 6702. Exemplary embodiments of 6704 are depicted and described elsewhere herein. Associated with the exemplary data network and infrastructure pipeline 6704 of FIG. 67, assets 6702 may represent one or more sources of asset information, such as business data, sensor data, outputs of portions of other pipelines, virtual data, and the like to which data network and infrastructure pipeline processes may be applied. In an exemplary transaction platform deployment of data network and infrastructure pipeline methods and systems, which is described elsewhere herein in greater detail, asset data 6702 may be applied through the data network and infrastructure pipeline 6704 to impact transaction outcomes, buyer and/or seller operating environments, market data, and the like, typically through configuring one or more marketplace parameters for conducting marketplace workflows for transactions of the assets.

In embodiments, a data network and infrastructure pipeline, such as 6704 may be configured with or operationally connected to a set of application programming interfaces (APIs) 6706 through which, among other things, asset data may be retrieved and/or received. In exemplary embodiments, an API 6706 for a data network and infrastructure pipeline may be an open/standardized API 6706 (e.g., banking/financial institution open APIs) that, among other things, may equip the data network and infrastructure pipeline 6704 for integration with and into current and emerging ecosystems. Use of open/standardized APIs 6706, while optional for some data network and infrastructure pipeline embodiments, may further enable these pipelines to integrate into a wide range of transaction workflows, such as corporate internal workflows, inter-jurisdiction transaction workflows, and the like.

A data network and infrastructure pipeline such as 6704 may include, reference, and/or provide market orchestration elements 6708 that may facilitate use of data network and infrastructure pipeline capabilities for various aspects of market orchestration, including, without limitations, software orchestrated transactions, software orchestrated marketplaces, and the like. Market orchestration elements 6708 may facilitate deployment of a data network and infrastructure pipeline, such as a web service embodiment, as an integrated function of a market orchestration platform, such as an automated market orchestration system of systems as described herein. In embodiments, a data network and infrastructure pipeline may provide data and network pipeline capabilities for market orchestration when configured as a portion of a data network and infrastructure pipeline 6704 in association with market orchestration elements 6708 and the like.

DP environment 6700 may include, reference and/or provide cross market interaction capabilities 6710 that may enable leveraging data network and infrastructure pipeline principals, computation capabilities, storage and data sourcing capabilities, as well as intelligence capabilities for cross market interactions. Cross market interaction capabilities 6710 may include interfaces to one or more marketplaces, transaction environments, and the like, so that, among other things, a data network and infrastructure pipeline may be configured with assets from one market in a cross-market integration deployment as a source of data and with another market in the cross-market integration deployment as a target recipient of the data network and infrastructure pipeline services. In embodiments, a similar arrangement may be constructed between two or more markets so that asset data in either market can be used as a data source and can be influenced by asset data from another market. Cross market interactions 6710 may be accomplished through one or more market-to-market data network and infrastructure pipelines for intelligent exchange of asset data among markets, such as data about assets of buyers in one market and about assets of sellers in another.

In the exemplary data network and infrastructure pipeline embodiment of FIG. 67, functions and processes 6712, for an exemplary market-oriented deployment may include software-oriented transaction functions and processes, automatic transaction transactions and processes, and the like. Functions and processes 6712 for a data network and infrastructure pipeline 6704 may include signaling availability of data (e.g., emergence of an occurrence of asset data) that impacts data provided to a transaction operator from (for example) a data and network infrastructure pipeline. Other exemplary functions and processes 6712 may include embedding network adaptability capabilities into smart contracts, tokens, publishing data on a schedule, or other occurrences (e.g., an initiation of a smart contract and the like). Yet other functions and processes may include payments between/among machines and the like.

In embodiments, a data network and infrastructure pipeline may include and/or be associated with data and network infrastructure pipeline technology enablers 6714, such as 5G networking, artificial intelligence, visualization technology (e.g., VR/AR/XR), distributed ledger, and the like.

In embodiments, a data network and infrastructure pipeline 6704 may include and/or leverage cloud-based virtualized containerization capabilities and services 6716, such as without limitation a container deployment and operation controller, such as Kubernetes 6718 and the like. Cloud-based virtualized containers may facilitate data network and infrastructure pipeline smart network resources being deployed close to asset data, thereby potentially reducing network bandwidth consumption or the potential for network disturbances in a data workflow and without substantive investment in infrastructure by the data network and infrastructure pipeline operator and/or consumer.

The data network and infrastructure pipeline of FIG. 67 may further include business system interfaces 6720, such as APIs and the like that facilitate adoption of data network and infrastructure pipelines by enterprises for development, among other things of a data-centric business workflow environment that enables cross-functional data use, seamless aggregation, and immediate contextualization of corporate data for individual departments, enterprise, subsidiary, and the like. Further integration of aspects of the data network and infrastructure pipeline into enterprise systems may include integration with one or more enterprise databases and the like.

Data network and infrastructure pipeline enabled markets 6722 may be enabled by and/or enhanced through the adoption of data and network infrastructure pipeline technology. Markets, such as markets at an intersection of financial service and physical product offerings may be revealed and/or enabled through application of these pipelines to help parse, analyze, and provide intelligence for a wide range of market-impacting and/or related assets. These emergent markets may be substantively constructed as a result of intelligence gathered by use of data network and infrastructure pipelines within or in association with individual markets, and the like.

Technologies that may be provided by and/or enabled by a data network and infrastructure pipeline 6704 may include intelligence services 6724, such as artificial intelligence, machine learning and the like. These intelligence services 6724 may be provided in the environment 6700, or accessed (e.g., as third-party services) via one or more interfaces of the environment 6700. The data network and infrastructure pipeline embodiment 6704 may be provided access to these intelligence services 6724. One or more data network and infrastructure pipeline embodiments 6704 may bring to the platform its own set of intelligence services, which may be dedicated to the host data network and infrastructure pipeline, or may be shareable among linked pipelines, for example.

In the exemplary embodiment of FIG. 67, transaction/market-oriented capabilities, services, and deployment may include market platforms 6726, transaction flows 6728, buyers 6732, sellers 6731, and transaction/marketplace specific data network and infrastructure pipelines that enrich transactions, transaction services and the like 6730. For multi-party transaction environments, a plurality of data network and infrastructure pipelines may be configured and operated to satisfy a range of consumer needs for market analysis, transaction efficiencies, cost containment, buy/sell decisions and the like.

Referring to FIG. 68, a data and network infrastructure pipeline 6804 is configured to deliver data from a set of assets 6802 to one or more marketplace entities for one or more marketplaces 6806 in which transactions for portions of the sets of assets 6802 are conducted. In example embodiments, the data from the set of assets 6802 is delivered by the pipeline 6804 to an interface by which an operator orchestrates a set of parameters for a set of transaction workflows involving the assets. The pipeline 6804 may be automatically configured to adjust a network path for delivery of data from the set of assets 6802 to the interface based on the characteristics of the data and at least one performance parameter of the network path. In example embodiments, the pipeline 6804 may be automatically configured to adjust timing of asset data delivery from the set of assets 6802 to the interface based on at least one of a transaction parameter and a network performance parameter.

Referring to FIG. 68, a data and network infrastructure pipeline 6804 is configured to deliver data from a set of assets 6802 for use in transactions in one or more marketplaces 6806 in which transactions for portions of the sets of assets 6802 are conducted. In example embodiments, the data from the set of assets 6802 is delivered by the pipeline 6804 to a set of smart contracts that include terms, conditions and parameters for a set of transaction workflows involving the assets, such as transaction workflows of transactions of the assets 6802 in the marketplace 6806. The pipeline 6804 may be automatically configured to adjust a network path for delivery of data from the set of assets 6802 to the set of smart contracts based on the characteristics of the data and at least one performance parameter of the network path. In example embodiments, the pipeline 6804 may be automatically configured to adjust timing of asset data delivery from the set of assets 6802 to the set of smart contracts based on at least one of a transaction parameter and a network performance parameter.

Referring to FIG. 69, the set of assets 6802 may include electronic device assets 6902 with electronic (e.g., wired/wireless) interfaces 6904 configured to deliver the data from and/or about the asset 6902 to an interface of the network pipeline 6804. The network pipeline 6804 may communicate with the interfaces 6904 through computer-to-computer networks, such as the internet and the like, using a range of protocols including TCPIP, and the like. One or more of the electronic assets in the set of electronic assets 6902 may communicate directly (e.g., through an interface) to the network pipeline 6804 through its corresponding interface 6904. Alternatively, a portion of the set of electronic device assets 6902 may be separated from the pipeline 6804 through an interface 6906, such as a local network router, gateway and the like. In example embodiments, the interface 6906 through which the portion of the set of electronic device assets 6902 may be a native interface of one of the electronic device assets 6902.

Referring to FIG. 70, the set of assets 6802 may include one or more assets 7002 that are managed by an asset management interface 7004 that is configured to deliver data pertinent to the asset 7002 for managing transactions of the one or more assets 7002 to the network pipeline 6804. The asset management interface 7004 may handle communication responsibilities associated with pertinent data for assets, such as one or more assets 7002 that do not have a communication capability, such as non-electronic physical assets. As an example, a set of assets 6802 may include one or more assets 7002 that does not have an interface through which the asset 7002 could communicate with the network pipeline 6804. In this example, the asset 7002 may be a battery, a piece of equipment, a structural member (e.g., a bridge truss), materials, and the like. The asset management interface 7004 may capture, such as through one or more sensors, cameras, human operators, and the like information about the asset, such as the asset external color, present location, asset weight, and the like. The asset management interface 7004 may capture information about the asset from a third-party information source, such as a warranty manual for the asset 7002, a last user of the asset 7002, and the like. The asset management interface 7004 may provide a capability for enabling use of the network pipeline 6804 to facilitate configuring, for example, parameters associated with transaction workflows for the asset 7002. The asset management interface 7004 may be configured to provide asset-relevant data for a single asset, a group of assets, and the like.

The network pipeline 6804 may communicate with the interfaces 7004 through computer-to-computer networks, such as the internet and the like, using a range of protocols including TCPIP, and the like. One or more of the assets in the set of non-electronic device assets 7002 may be depicted by its corresponding interface 7004 when communicating directly to the network pipeline 6804. Alternatively, a portion of the set of non-electronic device assets 7002 may be grouped and represented to the network pipeline 6804 through the interface 7004.

Referring to FIG. 71, the set of assets 6802 may include a plurality of types of assets 7102 including, without limitation, electronic device assets, non-electronic device assets, rights (e.g., digital), services, humans as assets, robotic fleet(s), and the like. The type of asset may be configured to provide information about aspects thereof, such as performance-related data, physical data, operational data, value data, data that defines parameters of use, jurisdictional data, and the like. As for asset types 7102 without a means of communicating with the network pipeline 6804, a suitable interface/controller 7104 may be configured to interface with the network pipeline 6804, similarly, at least in part, to that described herein for the asset management interface 7004 of FIG. 70. An electronic device type may provide information specific to its function, such as a sensor device that senses wind speed may provide wind speed data along with information that facilitates determining context of the data (e.g., how is it captured, capture timing, unit of measure, security data, and the like). A non-electronic device asset type may, such as through a suitable network pipeline interface 7104, expose information pertinent to transacting for the non-electronic device asset, such as physical, operational and other information that may enable an operator and/or a smart contract to configure one or parameters for conducting transactions of/for the asset. In example embodiments, asset data for service type assets may include information about the service as well as an indication of how to use the service, such as through a third party, through a network download of service software, through use of a network portal for receiving the services, and the like. Service-type assets, such as digital services, may be interfaced with the network pipeline 6804 through a computing device (e.g., a web server and the like) that provides the service. For physical-type service assets, such as in-field maintenance services, meal preparation services, energy supply services, and the like a suitable asset management interface module 7104 may facilitate providing information specific to types of physical service that can be leveraged by an operator and/or by a smart contract for orchestrating one or more transactions (e.g., including a transaction workflow) for the physical service assets. One such example includes a list of resources for providing the service(s) called out in the service-type asset.

An asset management interface, such as interface 7104, or interface 7004 may be embodied to provide, for example, asset-specific capabilities. An asset management system may also be configured to enable use of artificial intelligence and the like when generating and/or handling data about the asset. In example embodiments, an asset management interface may include a digital twin of the asset that may interface with the asset through one or more proprietary interfaces (or may independently monitor the asset) and provide near-real time data to the network pipeline 6804 that is consistent with the asset operational status, functionality, and the like. In example embodiments, an asset management interface, such as interface 7004 and/or 7104 may include a smart contract by which the asset is controlled or otherwise transacted. As an example, an asset may be a consumable supply item and a corresponding interface with the network pipeline 6804 may include a logistics service that provides inventory management, warehousing, distribution, and last-line delivery of the asset. Another asset type may include an on-demand built asset that may be represented to the network pipeline 6804 by one or more systems that produce and/or provide the on-demand built asset, such as a mobile 3D printing system that, based on a result of a transaction for an asset available to be built may build the asset while in transit to a recipient's identified destination. Yet another type of asset may include human assets. In example embodiments, human assets may be represented in the network pipeline 6804 through data provided from an asset management interface. An exemplary human asset management interface may include a business enterprise that employs the humans, such as a consulting agency that provides human resources for deployment to business tasks and the like. Another exemplary human asset management interface may include a set of sensors deployed to capture and provide pertinent information for use in marketplaces in which the human resources are transacted. As an example, a human may wear a smart watch that monitors a range of aspects, including some health aspects of the human. Data from the smart watch may be made available to the network pipeline 6804 when transactions regarding the human are being orchestrated, such as for identifying candidates for a sleep study for which a transaction is being conducted. Other monitoring devices, such as an electronic calendar system for the human may share data representative of an expected availability of the human for a future time frame for which humans (e.g., crowd sourcing) are being solicited in a transaction to perform a task.

Information provided to the network pipeline 6804 from or on behalf of an asset may cover a range of aspects of the asset. A few exemplary aspects are described here as examples of this range; however, these examples, or other description of such data is not to be dispositive of the full range and scope of data of or about an asset that is contemplated for use in the methods and systems of data network and infrastructure pipelining for marketplace orchestration and the like described herein. In example embodiments, aspects related to an expiration of the asset (e.g., use by date) or of an offer associated with the asset (time-limited pricing), and the like may be provided. Owners of perishable assets may derive a benefit from network pipeline delivery of this information being prioritized by the network data pipeline 6804 for urgent delivery, such as by organizing the network (e.g., configuring a route of the network) to prioritize delivery of information while the perishable asset remains usefulness to a perspective recipient in a transaction for the asset. In an example, an owner of a financial instrument that has an expiration date, such as an option in a stock market, may benefit from prioritization of delivery of information about the asset (e.g., its terms, pricing, expiration, and the like) based on context of market activity about the underlying financial instrument covered by the option. Owners of ripening assets may derive a benefit from network pipeline timing being adjusted based on a timing of the ripening asset becoming available.

Timing of asset data through a network pipeline 6804 may also be influenced by information about the asset, such as when the asset will be ready for delivery (or when the asset is expected to be delivered based on an estimate of delivery delays). Cross market transactions may benefit from a data network pipeline that adjusts timing of data delivery for a first asset based on information regarding a second asset. As an example, the timing of providing information from a service provider-type asset to a smart contract for providing services to owners of a serviceable asset may be adjusted based on information provided from the serviceable asset through the network pipeline 6804. The network pipeline 6804 may be configured to adjust delivery timing of data signaling an activation of a service contract based on information from the serviceable asset being provided to the network and transaction confirmation information derived from a workflow associated with a transaction for the serviceable asset.

In example embodiments, information relating to asset performance or reliability is another example aspect of asset data that may be provided from or on behalf of an asset through the network pipeline 6804. In an example related to asset reliability, information regarding a measure of reliability of providing energy from a wall battery in a private home that is charged by solar power may impact a value of the energy. In times of demand for energy, the private wall battery data, such as a historical record of timely release of energy may be valuable to orchestrating transactions in an energy marketplace where buyers seeking to purchase stored energy value such information. However, if a network pipeline 6804 fails to provide information about this potentially valuable source of energy in a timely manner, transaction for the energy may have been satisfied before the information can be used for orchestrating a transaction and the like. Therefore, a network pipeline 6804 may be configured to adjust a network path and/or prioritization of delivery of data through a configured network path based on a combination of a demand for a commodity (e.g., stored energy) and an aspect of performance of energy providing assets (e.g., an energy storage facility).

In example embodiments, information relating to asset capacity, or remaining inventory, may be provided from or on behalf of an asset through the network pipeline 6804. Use of a rechargeable service vehicle may be an asset for which a marketplace exists. In addition to basic information about the service vehicle (carrying capacity, etc.) and remaining charge of the service vehicle battery, the network pipeline 6804 may receive information about deployment of the asset that may impact, for example, pricing of the asset. In this example, use of the vehicle proximal to a charging station may be priced lower than use that results in the vehicle being located far from a charging station. Therefore, information about deployment of the asset, that may be sourced from other than the asset may be pertinent to transaction workflows in a marketplace for the asset. Similarly, information about an asset having an upcoming service event may be valuable to be provided through the network pipeline 6804. In this service event example, a path of asset data may be adjusted based on the upcoming service need, such as by directing information through the network to potential providers of the service. In this way, the network pipeline 6804 may configure a path for information about the asset that gathers information about an asset from a related third-party asset provider (e.g., a service provider asset) to improve orchestration of one or more transactions (e.g., configuring parameters and the like for transaction workflows) for the asset.

Another type of asset data that may be delivered by and influence adaptation of paths and/or timing of network infrastructure of network pipeline 6804 includes rapidly changing information, such as stock pricing, and other real-time impacted data. Such data may be provided from an asset as a data stream that includes changes in the asset data, such as bid, ask, and spread information for an electronically traded financial instrument, and the like.

Referring to FIG. 72, the data and network infrastructure pipeline 6804 may include a set of asset-centric intelligent network resources 7202 that may be disposed proximal to the set of assets 6802. The data and network infrastructure pipeline 6804 may further include a set of intermediate intelligent network resources 7204 that may be configured to deliver data from the set of assets 6802 through the network pipeline as described herein. The data and network infrastructure pipeline 6804 may also include a set of marketplace-centric intelligent network resources 7206 that may be disposed proximal to recipients of the asset data, such as interfaces associated with a marketplace 6806 in which one or more transactions (and associated transaction workflows) for the assets 6802 may be conducted. The one or more sets of intelligent network resources, such as sets of asset-centric resources 7202, intermediate resources 7204, or sets of marketplace-centric resources 7206 may be implemented in or in association with physical resources of a data communication network, such as the Internet and the like. Sets of asset-centric resources 7202 and/or sets of marketplaces (e.g., asset data recipient) centric resources 7206 may include network infrastructure resources, such as edge computing devices, inter-network interface devices (e.g., bridges, routers, and the like), aggregation devices, such as a distributed antenna system, and the like.

Referring to FIG. 73, the data and network infrastructure pipeline 6804 may include a set of asset-centric intelligent network resources 7202 that may be configured to deliver data from one or more sets of assets 6802 through the network pipeline 6804. These sets of asset-centric intelligent network resources 7202 may include a set of asset local resources 7302 that are configured by an asset local resource controller 7304 to work cooperatively with asset-centric data handling service 7306 to among other things manage use of asset-localized network storage 7308 to preserve the data delivered from the sets of assets 6802 for supporting network path and network delivery timing adaptations described herein. In example embodiments, the asset local resources 7302 may be configured to interface with intelligent assets, such as electronic assets 6902. The asset local resource controller 7304 may automatically determine, such as through a result of analysis of data from the electronic assets 6902 by the asset-centric data handling system 7306, configuration parameters for one or more of the sets of asset local resources 7302 to interface with one or more corresponding electronic assets of the set of electronic assets 6902. The asset local controller 7304 may retrieve such result of analysis from the asset-localized network store 7308.

Computing logic associated with an exemplary asset local resource 7302, such as a processing system or circuit thereof and the like, may be configured to execute communication protocols suitable for interacting with the interface 6904 of an electronic asset 6902, such as a specific asset data transfer protocol, and the like. As an example, a communication (sub) system of an exemplary local asset resource 7302 may be configured to communicate with an electronic device asset 6902 (e.g., through a corresponding asset interface 6904 and the like) to facilitate delivery of asset data over the network pipeline 6804, including without limitation the asset responding to queries for asset data from the network pipeline 6804. The asset local intelligent resource 7302, optionally in cooperation with the asset local resource controller 7304 and/or the asset-centric data handling system 7306 may facilitate processing of asset data and communication with an asset so that the network pipeline 6804 may be configured to deliver data from electronic asset 6902 independently of how a communication system of the asset might be programmed.

In other example embodiments, the set of asset local resources 7302 that are configured by an asset local resource controller 7304 to work cooperatively with asset-centric data handling service 7306 to among other things manage use of asset-localized network storage 7308 to preserve the data delivered from non-intelligent assets, such as through an asset management interface system 7004, including to preserve the data delivered from the assets for supporting network path and network delivery timing adaptations described herein. The asset local resource controller 7304 may automatically determine, such as through a result of analysis of data from the asset management interface system 7004 by the asset-centric data handling system 7306, configuration parameters for one or more of the sets of asset local resources 7302 to interface with one or more corresponding asset management interface systems 7004 of the set of non-electronic assets 6802. The asset local controller 7304 may retrieve such result of analysis from the asset-localized network store 7308.

Computing logic associated with an exemplary asset local resource 7302, such as a processing system or circuit thereof and the like, may be configured to execute communication protocols suitable for interacting with the asset management interface system 7004 of an asset of the set of assets 6802, such as a specific asset data transfer protocol, and the like. As an example, a communication (sub) system of an exemplary local asset resource 7302 may be configured to communicate with an asset management interface system 7004 to facilitate delivery of asset data over the network pipeline 6804, including without limitation the asset responding to queries for asset data from the network pipeline 6804. The asset local intelligent resource 7302, optionally in cooperation with the asset local resource controller 7304 and/or the asset-centric data handling system 7306 may facilitate processing of asset data and communication with an asset so that the network pipeline 6804 may be configured to deliver data from the asset management interface system 7004 independently of how a communication system thereof might be programmed.

In example embodiments, the sets of asset-centric intelligent network resources 7302 may be configured to deliver data from an asset collection (e.g., a local collection of assets within a facility, such as a production, warehousing, or other environment) through a set of asset environment local resources. These resources may be disposed logically and or physically within or proximal to a deployment environment for asset collection and may be configured by an asset environment local resource controller to work cooperatively with an asset-collection centric data handling service to among other things manage use of asset-localized network storage 7308 to preserve the data delivered from the assets for supporting network path and network delivery timing adaptations described herein. In example embodiments, an exemplary asset environment local intelligent resource of the set of resources may be configured to identify and communicate with at least a subset of individual assets within the collection. The asset environment centric data handling system may normalize data that is differentiated among the collection of assets to conform to a set of asset data requirements for format and the like. The asset environment centric data handling system may further and/or alternatively process data from the collection, selecting at least in part asset data to be delivered over the network pipeline 6804 (and/or optionally stored in asset-localized network store 7308) to facilitate adaptation of path and/or timing aspects of the network pipeline 6804 as described herein.

In general, configuration of and processing by asset local intelligent network resources 7302 and/or asset environment local intelligent network resources may be guided by knowledge of source assets to facilitate adapting aspects of the network pipeline 6804 according to the methods and systems described herein.

Referring to FIG. 74, the data and network infrastructure pipeline 6804 having a set of intermediate intelligent network resources 7204 may be adapted to deliver asset data from the asset local resources 7202 on to one or more marketplace related interfaces, such as a user interface, a smart contract, and the like. The set of intermediate intelligent network resources 7204 of FIG. 74 may include a network path adaptation/determination system 7402 that facilitates adapting a network path by producing an automatically adapted network route 7404 for the asset data. The network path adaptation/determination system 7402 may perform network path determination based on characteristics of the asset data. Aspects of the data that may impact network path adaptation/determination may include security requirements. In example embodiments, when an aspect of an asset (optionally expressed in or inferred from the data) indicates a high security requirement for transfer of the data through the network pipeline 6804, a network path may be adapted and/or determined by the path determination/adaptation system 7402 based on resource reputation. In an example, network resources identified as other than having a high security integrity score (e.g., resources that may be suspect for lacking security integrity and/or may not be cleared of potential malware) may be avoided when configuring a route through the network for the asset data. In example embodiments, resources that are not classified as either secure or suspect may be avoided.

In another example of network adaptation for data security considerations, the network adaptation system 7402 may adjust a transmission protocol to avoid exposing data from the asset in a context that gives meaning to the data. In example embodiments, adjusting a transmission protocol may include encrypting the data. In other examples adjusting a transmission protocol may include processing asset data, such as with the asset-centric data handling system 7306 and the like to separate data from relevant context, such as by sending a first transmission of a first portion of the data and sending a second transmission of a second portion of the data. Further, the network adaptation system 7402 may choose distinct routes for the two portions of data, thereby further reducing the potential for a resource in the adapted network path substantively compromising security of the data.

In another example of network path adaptation, a network path may be adapted dynamically. The network adaptation system 7402 may maintain a record of network paths configured for delivery of data from an asset and may adapt a route for the data so that it changes over time and in apparently arbitrary ways to further increase the secure handling of the data within the network pipeline 6804.

In yet another example of network path adaptation based on aspects of data from an asset, a network path may be determined based on one or more of a location of a source of asset data (e.g., a jurisdiction of a current location of the asset) and a location of a destination of the asset data (e.g., a jurisdiction of a marketplace, an operator interface, a smart contract, a participant/buyer of the asset, a deployment location of the asset, and the like). The network pipeline 6804 may include intermediate resources in a range of jurisdictions. Avoiding jurisdictions when adapting a network path for delivery of asset data through the network pipeline 6804 may be impacted by requirements and/or preferences of an asset owner, a recipient of asset data, an operator of the network pipeline 6804, a government agency, and the like. In example embodiments, although reference is made to jurisdictions, other ways of identifying one or more network resources to avoid are contemplated herein, such as based on IP address, costs associated with use of the network resources, performance (e.g., historical) of network resources, crowd-based recommendations for resources to avoid, use of artificial intelligence for path generation, and the like. In example embodiments, network path determination/adaptation may include, for example, configuring a Virtual Private Network (VPN) for delivery of asset data.

The network path adaptation/determination system 7402 may perform network path determination based at least one performance parameter of the network path. The network path adaptation/determination system 7402 may perform network path determination based on at least one of a transaction parameter and a network performance parameter. The network path adaptation/determination system 7402 may perform network path determination based on an aspect of a recipient of the asset data. A network path may be adapted in a first manner for a user interface recipient of the asset data, a second manner for a smart contract recipient of the asset data, a third manner for other recipients of the asset data.

The automatically adapted network route 7404 may facilitate delivery of asset data to, for example, the marketplace local resources 7206. The automatically adapted network route 7404 may be configured to deliver at least a portion of the asset data to one or more asset entities 7406 for handling one or more aspects of transactions of the assets, such as preparation of the assets, preparation of transaction-relevant information about/derived from the asset data and the like. Generally, configuring a network pipeline path may include routing asset data to specific entities, such as carriers, insurance providers, asset appraisers, regulatory agencies and the like. Determination of a path that may include delivery of at least a portion of asset data to an asset entity 7406 may be based on aspects of the set of assets 6802, such as based on analysis of asset data. In an example, an asset owner may indicate, such as through asset data delivered over the data network pipeline 6804, that transactions for the asset are to be performed through a specific transaction settlement vendor, such as a bank or other third party. In example embodiments, the network path adaptation system 7402 may, based on such an indication, route at least a portion of the asset data to a transaction settlement vendor that may be selected from the set of asset entities 7406 and the like. The network path determination system 7402 may further determine, based on insights gleaned from the asset data being provided to the network pipeline 6804 that an appraisal of the corresponding asset is outdated or otherwise may present a mitigating factor during a transaction for the asset. Based on this assessment, the network path determination system 7402 may configure a path that includes providing at least a portion of the asset data to an appraisal resource, optionally selected from the set of entity assets 7406. In example embodiments, the network path determination system 7402 may prescribe a network path that routes the portion of the asset data to the appraisal resource and works cooperatively with a network timing adjustment system 7408 to adjust timing of delivery of a portion of the asset data to one or more of the market-centric resources 7206. The timing may be adjusted so that delivery of the asset data to, for example, an interface of a marketplace through which an operator configures parameters for transaction workflows of the asset, is coordinated with delivery of asset appraisal results from the asset appraisal resource. The automatically adapted network route 7404 may further be configured to route data produced by or on behalf of the asset entities 7406 to the marketplace local resources 7206.

In example embodiments, adapting a network path may further be based on aspects of workflow steps for transactions of or associated with the assets. In an example of workflow impact on adapting a network pipeline path, a workflow may include an (optional) appraisal step that, unless activated in the workflow, would not be present in the transaction. Therefore, configuring a network path to include routing a portion of the asset data to the appraiser may be dependent on activation of an appraisal workflow task as, for example, a requirement of a transaction for the asset.

The set of intermediate intelligent network resources 7204 of FIG. 74 may include a network timing determination or adaptation system 7408 to facilitate, among other things, asset data or asset-related data delivery according to one or more time-related aspects of a transaction of the assets 6802. The network timing determination or adaptation system 7408 may configure a portion of an interconnected network, optionally including one or more network-accessible computing and/or storage resource into a network path with automatically adapted timing 7410. The network path configured with automatically adapted timing 7410 may deliver asset data and/or asset-relevant data (e.g., as may be produced by the asset entities 7406) to one or more marketplace local resources in the set of intelligent market local resources 7206. The network timing determination and adaptation system 7408 may perform network path timing adaptation in cooperation with one or more of the sets of asset-centric intelligent network resources 7202. In an example, the network timing determination and adaptation system 7408 may determine that asset data is to be scheduled for delivery no sooner than an earliest delivery date (e.g., after an announcement by the asset owner related to the asset). The network timing determination and adaptation system 7408 may communicate with, for example, the asset local resource controller 7304 and/or the asset-centric data handling system 7306 to process and/or store asset data in the asset-localized network store 7308. The network timing determination and adaptation system 7408 may, based on a signal that the earliest delivery data has occurred, retrieve or request to be retrieve the stored asset data for delivery through a network path configured for delivery. In example embodiments, configuring a network to comply with timing requirements associated with delivery of asset data may include configuring intermediate network storage (e.g., other than an asset-localized network storage facility 7308) to store relevant asset data.

In yet another example of automatically adapting an aspect of network timing for at least a portion of a network pipeline 6804 for providing data from a set of assets 6802 for use in configuring transaction workflows for the assets, a priority of network packets comprising the network data may be configured so that the asset data achieves a network delivery timing requirement. This may include configuring a network path based on known or anticipated performance of resources along the pipeline so that, for asset data that is to be delivered quickly, resources with lower performance scores may be avoided. Similarly, when timing for delivery of asset data can be extended, a network path may be selected to reduce costs of delivery of the data by choosing, for example lower cost resources that may induce delays in data delivery.

In example embodiments, configuring a network, such as timing-adapted network 7410 may include parking data for assets until a future time indicated by, for example a workflow for transacting the assets. As an example, a transaction workflow for a digital asset (e.g., access to a database and the like) may indicate that delivery timing of asset data, such as an access code and the like, is dependent on a transaction for the asset achieving a stage of transaction progression, such as a stage that results from a confirmation of payment being received for the asset. The network pipeline 6804 may be configured into a network timing adapted network configuration 7410 that parks the asset data conditionally based on the asset transaction workflow timing.

In example embodiments of FIG. 74, a network adaptation system may automatically construct a network infrastructure path in a network pipeline to deliver data from an asset to a market orchestration recipient, the constructed network infrastructure path may be automatically adapted based on one or more characteristics of the data from the asset and at least one performance parameter for the network infrastructure path. Further, a network timing adaptation system may automatically adapt network infrastructure resources in a network pipeline that delivers data from the asset to the market orchestration recipient for orchestration of a transaction of the asset. The network infrastructure resources may be adapted based on at least one of a parameter of the transaction of the asset and a performance parameter of the network pipeline. In the example embodiments of FIG. 74, a set of asset-centric network resources may facilitate ingestion of the data from the asset into the network pipeline. Also, a set of marketplace-centric network resources may facilitate delivery of the asset data from the adapted network pipeline to the market orchestration recipient. In example embodiments, the network pipeline may deliver the data from the asset to the market orchestration recipient for orchestration of a transaction of the asset. In an example of timing adaptation, the network timing adaptation system may adapt the network infrastructure resources in the network pipeline to satisfy a data delivery timing requirement associated with a transaction workflow for the asset. In another example of timing adaptation, the market orchestration recipient may include a smart contract that includes terms, conditions, and parameters for a set of transaction workflows involving the asset. Also in an example, adapting the network infrastructure path may be based on one or more security characteristics of the asset data, such as configuring a path through the network pipeline that avoids poor reputation network resources. In example embodiments, constructing a network infrastructure path in a network pipeline may include adjusting a communication protocol that avoids exposing data from the asset in a context that gives meaning to the data. This may include delivering a first portion of the asset data through a first network path and a second portion of the asset data through a second network path. Another example of secure-context protecting network path adaption may include adapting the network path for delivering the data from the asset so that the network path changes over time. Also, by ensuring that at least one infrastructure node in the constructed network path is different than infrastructure nodes used previously to deliver the data from the asset. In an example, adapting the network infrastructure path based on one or more characteristics of the data from the asset may include configuring a plurality of recipients for one or more portions of the data from the asset, wherein the plurality of recipients is determined from a transaction workflow for the asset.

Referring to FIG. 75, the data and network infrastructure pipeline 6804 may have a set of marketplace entities 7502 that may be configured proximal to one or more intelligent resources in the set of intelligent marketplace local resources 7206. The marketplace entities 7502 may be configured as computing modules capable of being instantiated with or within one or more computing elements, such as the marketplace local resources 7206, a network-accessible computing device, a network routing element, a computing system embodying one or more aspects of the marketplace 6806, and the like. The marketplace entities 7502 may include entities that provide services associated with performing transaction workflows for one or more of the set of assets 6802. The entities may provide services including electronic wallet services, digital twin services, enterprise database services, platform as a service, computer aided design services, video game services, and the like. Example embodiments of the methods and systems for data network and infrastructure pipeline adaptation incorporating one or more of these services are depicted in figures and described in corresponding disclosure herein.

Referring to FIG. 76, the set of marketplace-centric intelligent network resources 7206 may facilitate connecting recipients of the asset data to the adapted networks, such as route-adapted network 7404, timing-adapted network 7410, and other networks adapted to satisfy one or more of the transaction configurations and/or orchestration aspects described herein. The marketplace-centric intelligent network resources 7206 may be disposed variously within a network, such as an enterprise network, the Internet and the like. In example embodiments, resources 7206 may be disposed proximal to one or more target recipients of asset data. Further, independent of a physical location of one or more of the marketplace-centric intelligent network resources 7206 (and/or associated control systems), resources may be configured with functionality that provides marketplace-centric services, optionally utilizing computing resources of a corresponding asset data recipient, such as a computing system executing a smart contract recipient and the like. Example locations for marketplace-centric intelligent network resources 7206 includes locations proximal to a marketplace interface, such as a user interface through which an operator may orchestrate a set of parameters for a set of transaction workflows involving the assets. Another example location for marketplace-centric intelligent network resources 7206 includes locations that are proximal to a processor executing smart contracts that include terms, conditions and parameters for a set of transaction workflows involving the assets. Yet another example location for marketplace-centric intelligent network resources 7206 includes being disposed proximal to transaction workflow resources. In example embodiments, another example location for configuring marketplace-centric intelligent network resources 7206 includes proximal to asset enabling/utilization resources, such as asset entities 7502 and the like.

In example embodiments, a recipient of asset data may include a marketplace configuration interface, a smart contract interface, and the like as is described elsewhere herein. The set of marketplace-centric intelligent network resources 7206 may include a marketplace-centric intelligent resource 7602 that facilitates timely and efficient access by a marketplace 6806 to asset data and/or asset-related data that may be provided through the intermediate intelligent network resources 7204. The marketplace-centric intelligent resource 7602 may coordinate access to asset data by an interface of a marketplace, such as an interface through which an operator may orchestrate a set of parameters for a set of transaction workflows involving the assets.

The set of marketplace-centric intelligent network resources 7206 may include a set of workflow centric resources 7608 that may facilitate timely and efficient access by a set of workflow resources 7610 to asset data and/or asset-related data that may be provided through the intermediate intelligent network resources 7204. The set of workflow resources 7610 may be configured with services that manage access by a workflow for a transaction of an asset to data for the asset. In an example, a transaction workflow resource 7610 may include a utilization charge associated with use of the asset associated with the transaction (e.g., miles driven for a rental car transaction). The set of workflow centric resources 7608 may determine that this information is useful to a corresponding step in the transaction workflow (e.g., payment to an asset owner for the utilization of the asset). In example embodiments, the set of workflow centric resources 7608 may determine that this information is useful by analysis of the workflow, such as through use of artificial intelligence service analysis. In example embodiments, the set of workflow centric resources 7608 may determine that this information is useful based on one or more workflow parameters, such as one or more workflow parameters in a set of parameters for the transaction workflow for the asset orchestrated by an operator (e.g., a utilization parameter). The set of workflow centric resources 7608 may coordinate with aspects of the network pipeline 6804 resources, such as a controller 7304 for an asset-localized network store 7308 in which utilization data for the asset is stored. The set of workflow centric resources 7608 may, based on the utilization parameter for a corresponding transaction workflow may initiate configuration of a utilization measure capture function to be performed by an asset local controller 7304 that is configured to work cooperatively with the asset, such as intelligent asset 7302. In example embodiments, the set of workflow-centric resources 7608 may further coordinate with a network timing determination/adaptation system 7408 to adjust a network configuration for delivery of the utilization data based on requirements in the workflow. In this example, a step in a transaction workflow may indicate that utilization data for the asset is to be provided periodically, such as at the end of a day to be processed by functions of the workflow step. The set of marketplace-centric intelligent resources 7608 may indicate to the network timing determination/adaptation system 7408 to configure a logical connection between the asset and the workflow daily at 12:02 AM to deliver utilization information for the previous day. In example embodiments, the network timing determination/adaptation system 7408 may configure a logical connection between an asset-centric intelligent resource 7202 through which the asset connects to the network pipeline 6804. For this approach, the asset-centric intelligent resource 7202 can provide the information in compliance with the workflow requirements (e.g., 12:02 AM) while interfacing to the asset utilizing asset-centric methods, such as capturing utilization data at a time determined in cooperation with the asset (e.g., at the end of a work shift that utilizes the asset), which may be different than the time specified by the workflow.

The set of marketplace-centric intelligent network resources 7206 may include a set of smart contract-centric resources 7604 that may facilitate timely and efficient access by a set of smart contracts 7606 to asset data and/or asset-related data that may be provided through the intermediate intelligent network resources 7204. In example embodiments, the smart contracts 7606 may include terms, conditions and parameters for a set of transaction workflows involving the assets. For an energy storage asset, such as an electricity storage module in a distributed energy storage system, the smart contract-centric resources 7604 may facilitate monitoring stored energy in a plurality of storage modules to satisfy a condition of a smart contract identified in a transaction workflow for use of energy from the distributed energy storage system modules.

The set of marketplace-centric intelligent network resources 7206 may include a set of asset delivery/use-centric resources 7612 that may facilitate timely and efficient access by a set of asset use/enabling resources 7614 to asset data and/or asset-related data that may be provided through the intermediate intelligent network resources 7204. In example embodiments, adapting a route and/or timing of delivery of data through the network pipeline 6804 may be based on an intended use and/or deployment of an asset by a corresponding asset use/enabling resource 7614. An asset use/enabling resource 7614 may be designated by a participant in a transaction for the asset. IN an example, a municipal agency may be negotiating for use of stored energy. The municipal agency may have a contractual agreement (e.g., via a union contract and the like) to engage a specific fee-setting third-party for use of stored energy supplies. Based on this arrangement, a network pipeline 6804 may include adjusting a path for asset data to include the specific fee-setting third-party as a recipient of the asset data. In another stored energy transaction scenario, asset use/enabling resources 7614 may include mobile equipment that is dispersed across a plurality of jurisdictions. The asset delivery/use centric resources 7612 may include one or more consolidation resources (e.g., a network infrastructure edge computing device) that coordinate energy demand from groups of the dispersed resources 7614. In example embodiments, such a consolidation resource may be configured for different jurisdictions to facilitate compliance with resource 7614 requirements, and also with jurisdiction-specific requirements.

In example embodiments, the set of marketplace-centric intelligent network resources 7206 may facilitate adaptation of a path and/or timing in a network pipeline 6804 based on requirements of transaction workflows. A resource providing such a service to the workflow may be disconnected from (e.g., indirectly associated with) the asset. Further the resource providing the service may be determined by and/or impact aspects of the transaction workflow. In an example, a service provided by resource X causes an impact Y on a workflow for transactions of the asset. As a result, the network pipeline 6804 may response to this impact by adjusting a network path for data from the asset to include resource X.

Referring to FIG. 77, a data and network infrastructure pipeline 6804 is configured to deliver data from a set of assets 6802 to an interface 6752 by which an operator orchestrates a set of parameters 6754 for a set of transaction workflows 6756 involving the assets. The data and network infrastructure pipeline 6804 may include a route-determined path 7404 that is automatically adapted based on one or more characteristics of the asset data and at least one performance parameter of a (model/initial/default/random/third-party prescribed) network path. Techniques for adapting the route-determined path 7404 are depicted in the figures of this disclosure and described elsewhere herein, including without limitation FIG. 74 and its accompanying descriptions. The data and network infrastructure pipeline 6804 may include a time-determined path 7410 that is automatically adapted based on one or more characteristics of the asset data and at least one performance parameter of an (initial/model/default/random/third-party prescribed) network path. Techniques for adapting the time-determined path 7410 are depicted in the figures of this disclosure and described elsewhere herein, including without limitation FIG. 74 and its accompanying descriptions.

Adapting one or more of a network path or timing of delivery of data through the network pipeline 6804 may include use of an application programming interface associated with the operator interface 6752.

In example embodiments, the method and systems for adapting routing and/or timing for delivering data through a network pipeline 6804 may include use of a digital twin platform. A digital twin platform may include digital twins of assets, marketplaces, workflows, and the like. Adapting a network path through the network pipeline 6804 may include adapting a network path to provide data to a digital twin of the asset. Adapting timing of data delivery through the network pipeline 6804 may include adapting timing of delivery of asset and/or asset-related data to the digital twin of the asset.

In example embodiments, the method and systems for adapting routing and/or timing for delivering data through a network pipeline 6804 may include use of robotic process automation of, for example adapting a network route and/or adapting timing. Use of robotic process automation may also include developing automation of operator actions within the operator interface 6752, such as actions that configure workflow parameters 6754.

Adapting a network path through the network pipeline 6804 may include adapting a network path to provide data to a digital twin of the asset. Adapting timing of data delivery through the network pipeline 6804 may include adapting timing of delivery of asset and/or asset-related data to the digital twin of the asset.

In example embodiments, an operator may orchestrate workflow parameters through the operator interface 6752. Factors that may impact workflow parameters 6754 may include an understanding of a relationship among, for example, an owner of the asset and a recipient of a transaction for the asset. For close relationships, transaction workflow parameters 6754 may be orchestrated by the operator to enable direct transfer of the asset and/or asset data. A corresponding adaptation a route for asset data in the network pipeline 6804 may include a route from the asset to the recipient. For indirect relationships, transaction workflow parameters 6754 may be orchestrated to include use of an escrow intermediary. A corresponding adaptation a route for asset data in the network pipeline 6804 may include a route from the asset to an escrow agent and then, conditionally to the recipient.

Asset data received at the operator interface 6752 may include transaction financial terms. The operator may, based on this data, configure workflow parameters to satisfy the financial terms. As an example, for asset owners that accept cash, workflow parameter may be configured to ensure that a corresponding workflow has access to cash accounts of the asset owner and asset buyer. In another example, for asset owners that offer funding for a transaction for the asset, workflow parameters may be configured with an indication of a financing set of steps to be included in the corresponding transaction workflow. Financing steps may include, without limitation, an asset valuation step, a lender solicitation step, a terms negotiation step, and the like. Another type of impact on workflow parameters may include broker or other commissions associated with a transaction for the asset. The operator may, through the operator interface 6752 determine that the asset transaction includes an affiliated party, such as a broker, who may be entitled to receive a broker's commission for the transaction. Workflow parameters 6754 for a corresponding asset transaction workflow 6756 may indicate the broker and/or a commission structure.

Referring to FIG. 78, a data and network infrastructure pipeline 6804 is configured to deliver data from a set of assets 6802 to an interface for a set of smart contracts 6852. The smart contracts may react to asset data in the interface based on a set of terms, conditions, parameters, and the like 6854. The smart contract terms, conditions, parameters and the like may apply to a set of transaction workflows 6856 involving the assets. The data and network infrastructure pipeline 6804 may include a route-determined path 7404 that is automatically adapted based on one or more characteristics of the asset data and at least one performance parameter of an (initial/model/default/random/third-party prescribed) network path. The data and network infrastructure pipeline 6804 may include a time-determined path 7410 that is automatically adapted based on one or more characteristics of the asset data and at least one performance parameter of an (initial/model/default/random/third-party prescribed) network path.

In example embodiments, terms of a smart contract 6852 may include controlled access to data from the set of assets 6802. A route in the network pipeline 6804 may be adapted to prevent access to the data until a term impacting a workflow 6856 is satisfied. The network route may be adapted so as to deny access to the data based on a condition of the workflow. The network route may be adapted so that requests to access the data before the condition in the workflow is met may be deflected (e.g., rerouted) to a resource in the network that provides a suitable response, such as access is withheld due to a condition in the workflow conditions 6854 not yet being detected by the workflow 6856. In addition to denying access to the asset data based on the unsatisfied condition, the network pipeline 6804 may be adapted to prevent changes to the asset data during the time that the workflow condition is unsatisfied, such as by changing privileges for the asset to restrict access to reading, but not writing to the asset.

In example embodiments, workflows terms 6854 regarding timing of completion of one or more workflows for a transaction for an asset may impact at least one of a route and timing of transfer of data about or of the asset through the network pipeline 6804. A compound transaction or an electronically tradeable asset (e.g., buy and sell) may benefit from adjustment of the network, such as to minimize time between a buy portion of the transaction and a sell portion of the transaction to, for example, mitigate a possibility of an impact on the asset value after the asset is bought and before it is sold.

Referring to FIG. 79, methods and systems are described herein as having a data and network infrastructure pipeline that is configured to deliver data from a set of assets to at least one of a smart contract interface 6852 and/or an operator interface 6752 may further have a set of application programming interfaces 6954 to a marketplace 6806 that are configured to be integrated into an electronic wallet system 6952. In example embodiments, interactions with a set of electronic wallet interfaces 6956 of the wallet system 6952 may automatically trigger a set of transaction workflows 6756 within the marketplace 6806. In example embodiments, the electronic wallet system 6952 may control an electronic wallet associated with an entity for settlement of transactions. The electronic wallet system interface 6956 may function to receive one or more signals for the electronic wallet system 6952 about a transaction for the assets 6802. The marketplace API 6954 may be configured to interface with a computing system executing and/or controlling the asset workflows 6756 so that, based on one or more signals (e.g., from the marketplace indicating transaction success) optionally provided through the electronic wallet system interface 6956, a workflow step (e.g., record transfer of ownership of the asset in a distributed ledger) may be automatically activated.

Referring to FIG. 80, methods and systems are described herein as having a data and network infrastructure pipeline that is configured to deliver data from a set of assets to at least one of a smart contract interface 6852 and/or an operator interface 6752 may further have a set of application programming interfaces 6954 to a marketplace 6806 that are configured to be integrated into a digital twin platform 7052. In example embodiments, interactions with a set of digital twin interfaces 7056 of the digital twin platform 7052 may automatically trigger a set of transaction workflows 6756 within the marketplace 6806. In an exemplary embodiment, the digital twin platform 7052 may execute a digital twin of the asset. Activity of the asset may be captured by the asset digital twin in the digital twin platform 7052. The marketplace 6806 may interact with the asset digital twin in the digital twin platform 7052 through the marketplace API 6954 that may be integrated in the digital twin platform 7052. The asset digital twin may be informed by the marketplace 6806 that the assets is presently being transacted. The asset digital twin may signal, through the marketplace API 6954 to activate a step in an asset workflow 6756 that includes authentication of the present transaction for the asset.

Referring to FIG. 81, methods and systems are described herein as having a data and network infrastructure pipeline that is configured to deliver data from a set of assets to at least one of a smart contract interface 6852 and/or an operator interface 6752 may further have a set of application programming interfaces 6954 to a marketplace 6806 that are configured to be integrated into an enterprise database platform 7152. In example embodiments, interactions with a set of enterprise database interfaces 7156 of the digital enterprise database platform 7152 automatically trigger a set of transaction workflows 6756 within the marketplace 6806. Through integration into an enterprise database platform 7152, the methods and systems of network pipeline 6804 adaptation for routing and/or timing may enable integration into business applications, methods and processes of the enterprise. In example embodiments, business workflows, such as inventory replenishment may include a workflow step that signals to the enterprise database platform 7152 (e.g., through the set of enterprise database interfaces 7156) to conduct a transaction for initiating the replenishment. Through the set of application programming interfaces 6954, the marketplace workflows 6756 a transaction may be conducted (and or an existing transaction may be continued), such as releasing an order for inventory material from a supplier.

Referring to FIG. 82, methods and systems are described herein as having a data and network infrastructure pipeline that is configured to deliver data from a set of assets to at least one of a smart contract interface 6852 and/or an operator interface 6752 may further have a set of application programming interfaces 6954 to a marketplace 6806 that are configured to be integrated into a platform as a service platform 7252. In example embodiments, interactions with a set of service platform interfaces 7256 of the platform as a service platform 7252 automatically trigger a set of transaction workflows 6756 within the marketplace 6806. In this example embodiment, the platform as a service platform 7252 may receive a request for performing a platform service through the set of service platform interfaces 7256. Responsive to this request, the platform as a service platform may indicate, through the set of marketplace APIs 6954 to activate a transaction workflow 6756 that correlates to a type of service indicated in the request.

Referring to FIG. 83, methods and systems are described herein as having a data and network infrastructure pipeline that is configured to deliver data from a set of assets to at least one of a smart contract interface 6852 and/or an operator interface 6752 may further have a set of application programming interfaces 6954 to a marketplace 6806 that are configured to be integrated into a computer aided design platform 7352. In example embodiments, interactions with a set of CAD interfaces 7356 of the computer aided design platform 7352 automatically trigger a set of transaction workflows 6756 within the marketplace 6806. In example embodiments, a computer aided design platform 7352 may represent a resource through which an asset-specific transaction workflow might be fulfilled, such as designing the asset, designing aspects of a deployment environment for the asset, and the like. In example embodiments, the computer aided design platform 7352 may perform automated design using a set of criteria provided through, for example the set of CAD interfaces 7356. The automated design may include following a set of workflow steps for producing the automated design that are based on information provided from the computer aided design platform 7352 through the marketplace APIs 6954 to a workflow selector mechanism for adapting a workflow to fulfill the design requirement.

Referring to FIG. 84, methods and systems are described herein as having a data and network infrastructure pipeline that is configured to deliver data from a set of assets to at least one of a smart contract interface 6852 and/or an operator interface 6752 may further have a set of application programming interfaces 6954 to a marketplace 6806 that are configured to be integrated into a video game 7452. In example embodiments, interactions with a set of game interfaces 7456 of the video game 7452 automatically trigger a set of transaction workflows 6756 within the marketplace 6806. Integration of a set of marketplace APIs AP1204 into a video game 7452 may facilitate presentation of sets of assets 6802 available for transaction in the marketplace 6806 in a user interface of the video game 7452. As an example, during use of the video game 7452 a user may identify an asset to be transacted, such as to be purchased in the marketplace 6806 by the user. Through use of the marketplace APIs 6954, a workflow of the marketplace may be activated to fulfill a transaction for the asset on behalf of the game user.

Methods and systems of a route and timing adaptable network pipeline for delivering data from an asset may include a data and network infrastructure pipeline 6804 that is configured to deliver data from a set of assets 6802 to an interface 6752 by which an operator orchestrates a set of parameters 6754 for a set of transaction workflows 6756 involving the assets, wherein the pipeline 6804 is automatically configured to adjust a network path 7404 based on the characteristics of the data and at least one performance parameter of the network path.

Methods and systems of a route and timing adaptable network pipeline for delivering data from an asset may include a data and network infrastructure pipeline 6804 that is configured to deliver data from a set of assets 6802 to a set of smart contracts 7606 that include terms, conditions and parameters 6854 for a set of transaction workflows 6856 involving the assets, wherein the pipeline 6804 is automatically configured to adjust a network path 7404 based on the characteristics of the data/contracts/terms/conditions/parameters/workflows/assets and at least one performance parameter of the network path. In example embodiments, a path may be changed based on meeting one or more conditions of the smart contract. In a production system that produces one or more assets in the set of assets 6802, meeting one or more conditions, such as a level of production quality, may satisfy a quality condition regarding use of a quality monitoring service (e.g., auditing quality of a production system). Based on achieving a level of production quality, sample assets (and/or quality data for assets) may no longer be routed to the quality auditing service/network resource. This change in path of asset data may be affected by the method and systems for network pipeline 6804 operation as described herein.

Methods and systems of a route and timing adaptable network pipeline for delivering data from an asset may include a data and network infrastructure pipeline 6804 that is configured to deliver data from a set of assets 6802 to an interface 6752 by which an operator orchestrates a set of parameters 6754 for a set of transaction workflows 6756 involving the assets, wherein the pipeline 6804 is automatically configured to adjust timing of data delivery based on at least one of a transaction parameter and a network performance parameter. A network performance parameter may include an expected delivery timing for data delivery, a range of data delivery timing for delivering the asset, and the like. A transaction parameter may include a target data delivery time frame, a maximum data delivery time (so that data is received timely), a minimum data delivery time (so that data is received after a minimum time, such as after a specific date/time, and the like).

Methods and systems of a route and timing adaptable network pipeline for delivering data from an asset may include a data and network infrastructure pipeline 6804 that is configured to deliver data from a set of assets 6802 to set of smart contracts 7606 that include terms, conditions and parameters 6854 for a set of transaction workflows 6856 involving the assets, wherein the pipeline 6804 is automatically configured to adjust timing of data delivery based on at least one of a transaction parameter and a network performance parameter.

In embodiments, provided herein are computer-implemented methods and systems for automated orchestration of one or more marketplaces, such methods and systems having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter.

In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a set of application programming interfaces 6954 to a marketplace 6806 that are configured to be integrated into an electronic wallet system 6952, such that interactions with a set of interfaces 6956 of the wallet system automatically trigger a set of transaction workflows 6756 within the marketplace 6806. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a set of application programming interfaces 6954 to a marketplace 6806 that are configured to be integrated into a digital twin platform 7052, such that interactions with a set of interfaces 7056 of the digital twin platform 7052 automatically trigger a set of transaction workflows 6756 within the marketplace 6806. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a set of application programming interfaces 6954 to a marketplace 6806 that are configured to be integrated into an enterprise database platform 7152, such that interactions with a set of interfaces 7156 of the enterprise database platform 7152 automatically trigger a set of transaction workflows 6756 within the marketplace 6806. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a set of application programming interfaces 6954 to a marketplace 6806 that are configured to be integrated into a platform-as-a-service platform 7252, such that interactions with a set of interfaces 7256 of the platform-as-a-service platform 7252 automatically trigger a set of transaction workflows 6756 within the marketplace 6806. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a set of application programming interfaces 6954 to a marketplace 6806 that are configured to be integrated into a computer-aided design platform 7352, such that interactions with a set of interfaces 7356 of the computer-aided design platform 7352 automatically trigger a set of transaction workflows 6756 within the marketplace 6806. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust a network path based on the characteristics of the data and at least one performance parameter of the network path and having a set of application programming interfaces 6954 to a marketplace 6806 that are configured to be integrated into a video game 7452, such that interactions with a set of interfaces 7456 of the video game 7452 automatically trigger a set of transaction workflows 6756 within the marketplace 6806.

In embodiments, provided herein are computer-implemented methods and systems for automated orchestration of one or more marketplaces, such methods and systems having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a set of application programming interfaces to a marketplace that are configured to be integrated into an electronic wallet system, such that interactions with a set of interfaces of the wallet system automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a set of application programming interfaces to a marketplace that are configured to be integrated into a digital twin platform, such that interactions with a set of interfaces of the digital twin platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a set of application programming interfaces to a marketplace that are configured to be integrated into an enterprise database platform, such that interactions with a set of interfaces of the enterprise database platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a set of application programming interfaces to a marketplace that are configured to be integrated into a platform-as-a-service platform, such that interactions with a set of interfaces of the platform-as-a-service platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a set of application programming interfaces to a marketplace that are configured to be integrated into a computer-aided design platform, such that interactions with a set of interfaces of the computer-aided design platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust a network path based on the characteristics of the data and at least one performance parameter of the network path and having a set of application programming interfaces to a marketplace that are configured to be integrated into a video game, such that interactions with a set of interfaces of the video game automatically trigger a set of transaction workflows within the marketplace.

In embodiments, provided herein are computer-implemented methods and systems for automated orchestration of one or more marketplaces, such methods and systems having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter and having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into an electronic wallet system, such that interactions with a set of interfaces of the wallet system automatically trigger a set of transaction workflows within the marketplace. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a digital twin platform, such that interactions with a set of interfaces of the digital twin platform automatically trigger a set of transaction workflows within the marketplace. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into an enterprise database platform, such that interactions with a set of interfaces of the enterprise database platform automatically trigger a set of transaction workflows within the marketplace. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a platform-as-a-service platform, such that interactions with a set of interfaces of the platform-as-a-service platform automatically trigger a set of transaction workflows within the marketplace. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a computer-aided design platform, such that interactions with a set of interfaces of the computer-aided design platform automatically trigger a set of transaction workflows within the marketplace. In embodiments, such methods and systems are provided having a data and network infrastructure pipeline that is configured to deliver data from a set of assets to an interface by which an operator orchestrates a set of parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a video game, such that interactions with a set of interfaces of the video game automatically trigger a set of transaction workflows within the marketplace.

In embodiments, provided herein are computer-implemented methods and systems for automated orchestration of one or more marketplaces, such methods and systems having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into an electronic wallet system, such that interactions with a set of interfaces of the wallet system automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a digital twin platform, such that interactions with a set of interfaces of the digital twin platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into an enterprise database platform, such that interactions with a set of interfaces of the enterprise database platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a platform-as-a-service platform, such that interactions with a set of interfaces of the platform-as-a-service platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a computer-aided design platform, such that interactions with a set of interfaces of the computer-aided design platform automatically trigger a set of transaction workflows within the marketplace. In embodiments, such methods and systems are provided having a data and network infrastructure pipeline that is configured to deliver data from a set of assets to set of smart contracts that include terms, conditions and parameters for a set of transaction workflows involving the assets, wherein the pipeline is automatically configured to adjust timing of data delivery based on at least one of a transaction parameter and a network performance parameter and having a set of application programming interfaces to a marketplace that are configured to be integrated into a video game, such that interactions with a set of interfaces of the video game automatically trigger a set of transaction workflows within the marketplace.

### Cross-Market Transaction Engine

There is a huge proliferation of data resulting from the IoT, edge and distributed storage and computation, but more data is not useful if the data overwhelms storage systems, networks for transmission, or human operators with too much noise to be useful. Referring to FIG. 85 and FIG. 86 in embodiments, the platform 100 may include a cross-market transaction engine 8500 configured to enable markets 8502, market platforms 8504, buyers 8506, and sellers 8508 participating in a wide variety of markets to execute transactions and share data via intelligent agents and intelligent data layers 5604. The engine 8500 may discover new data source feeds (including alternative data like crowdsourced data, IoT and sensor data, edge and cloud, and websites), automatically ingest, cleanse, and normalize the feeds such that they can be processed, organize storage of the data (including self-organization based on feedback on outcomes, such as utilization, impact, for example whether new data helps AI perform better, etc.), deduplicate and/or prune the data, summarize or compress the data (such as to optimize storage and/or network transmission), handle access controls, including role-based permissions and appropriate encryption or obfuscation), as well as handling permissions in multi-tenancy situations, perform opportunity mining (such as by testing the impact of adding new data sources on the performance of AI and expert systems), factor in the cost/benefit of adding the data source, perform network-condition-sensitive data acquisition and storage (such as assisting with not collecting more sensitive data than one can transmit, collecting data at the right time of day to transmit, etc.), and/or perform intelligent data location (such as putting the data where the data belongs for an AI model to operate on the data, e.g., as where a local AI system can operate a market function with very low latency on the local data that is “good enough” to get to a good answer, such as the right price for a bid/ask situation. The engine 8500 may perform or facilitate performing one or more of reducing data-sharing risk, securing data provenance, facilitating transaction autonomy, driving ecosystem interoperability, securely augmenting AI, translating value, and parking value. The engine 8500 may reduce data-sharing risk by creating combined sources of information that can be queried and analyzed without providing all users with full access to the underlying data sources or otherwise revealing the underlying data, for example via distributed data storage and associated technologies (e.g., cloud, distributed ledgers, smart contracts, blockchains, and access control systems) with privacy enhancing techniques (PETs). This may include providing aggregated results that do not provide access to individual data elements (such as to protect the privacy of a user or individual proprietary units), providing obfuscated results, providing summaries, providing partial results (e.g., reduced-granularity image or sensor data), and/or tuning results to roles, permissions, or other parameters of a requesting party or system.

The engine 8500 may secure data provenance by facilitating creation and/or management of a blockchain-based distributed ledger, thereby creating immutable sources of information that allow for tracing the provenance of information (e.g., data from IoT devices sent over 5G networks), more easily reconciling data with collaborators, and minimizing the risk of information being doctored by malicious actors. Data provenance may also be facilitated by embedding or wrapping data elements in metadata that indicates or validates provenance, such as a digital fingerprint or signature that is unique to the data source (e.g., wrapping sensor data for a time period with a digital signature that embeds a unique characteristic of the device or system that was used to capture the data, the environment in which it was captured, or an item about which the data was collected).

The engine 8500 may facilitate transaction autonomy by facilitating creation and/or management of smart contacts on one or more distributed ledgers, thereby reducing the effort spent manually reconciling agreements and processing transactions (as they happen automatically) and allowing for real-time and autonomous payments to flow to different types of partners upon completion of specific contractual terms. Transaction autonomy may also be facilitated by a set of autonomous agents, such as robotic process automation systems that are trained on a set of user actions (such as a training set of user interactions with one or more software systems that are used to enable transactions), such that elements of a transaction that historically required manual or human interactions are undertaken by the agents.

The engine 8500 may drive ecosystem interoperability by standardizing various connectivity methods (e.g., Open API initiative, NACHA's API standardization), outsourcing to as-a-service providers (e.g., those accessible via the cloud), sending financial instructions, and/or embedding products into non-financial contexts.

The engine 8500 may securely augment AI by employing privacy-enhancing techniques to allow AI models to be trained (using task-specific hardware) on sensitive information without exposing training, which may be beneficial, for instance, in creating collective transaction monitoring models without exposing sensitive transaction data to competitors. The privacy-enhanced training data communication allows for building robust artificial intelligence models using large amounts of data from partners without compromising privacy and security. AI models may be augmented by a governance system, such as one that governs the training data set and/or a set of outcomes that results from application of the AI to the training data set, such as to avoid replicating bias in training data sets in the outcomes of models, to provide expert checks and balances on automated systems, to ensure compliance with regulations (such as privacy regulations, data location regulations, and operational regulations that apply to activities that are undertaken based on the outputs of the AI models).

The engine 8500 may facilitate translation and parking of value by providing a plurality of markets with access to and sharing of technologies that provide insight into the “right” exchange rate, e.g., between native currencies of respective markets and exchange rates across markets, as well as provide insight into the value (as expressed in various units of value) of in-market entities like data, lifetime value of a customer, cost to acquire a customer, targeted advertising rates, goods, services, credits, offsets, tokens, loyalty points, collateral, labor, work products, credit costs (borrowing or lending), and many others. The engine 8500 provides such exchanges with better solutions that can be enabled by more/richer data (including in intelligent data layers), better automation (including using agents and models that are trained on data and that use AI), and/or better analytic and AI systems that facilitate insight into transactions, workflows, value-creation and other elements of a successful marketplace.

In embodiments, the engine 8500 may facilitate one or more processes by which market values of a set of tokens (such as NFTs, fungible tokens, or others) may provide a translation function between markets. The token market values may be measured according to one or more cryptocurrencies, fiat currencies, points systems (e.g., rewards or loyalty points), or a combination thereof. For example, value of a painting may be measured versus value of an event ticket by their respective cost as reflected in the same token, cryptocurrency, or fiat currency. In embodiments, a set of tokens may be designed to provide better insight about exchange value than traditional currency or generalized cryptocurrency, such as where a token is managed by a set of market orchestration rules and/or smart contracts that take real-time data from a set of market entities that indicate value. In embodiments, this may include populating the systems that govern a token with data from a digital twin that reflects the current or real-time condition of a set of real-world assets, such as based on sensor data, human-entered observational data, or any other data.

In embodiments, the engine 8500 may facilitate one or more processes by which a parameterized smart contract may be configured to define one or more value ranges for in-kind exchanges across markets. The engine 8500 may periodically spider available marketplaces to find a preferred set of potential exchanges.

In embodiments, the engine 8500 may be configured to embed financial products in non-financial contexts, and/or embed non-financial products in financial contexts. Non-financial players can be incentivized to create exclusive arrangements to embed only a particular institution's product, giving them direct access to captive customer pools and exclusive data. This addresses a challenge that financial institutions face when financial products are embedded into a third-party platform, in which case the institution may risk losing direct customer touchpoints, limiting the ability to build deeper relationships (e.g., advisory relationships between a bank and its high-value customers). In embodiments, advances in connectivity technology and standardization allow financial products to be natively integrated into non-financial contexts. For instance, a financial product may be delivered simultaneously with a non-financial one (e.g., parametric insurance may be built into a home purchase contract) or offered natively on the platform of a partner (e.g., gig-work app making short-term loans). Examples include machinery as a service, printing as a service, and other subscription models. Integration or embedding of financial and non-financial products and services with or into each other may be improved by combination with any of the elements described herein, such as: access to a set of intelligent data layers that provide automated, high-quality, real-time data to parameterize financial or non-financial data, such as to inform a smart contract relating to the embedded or integrated offering; presentation of offerings in improved interfaces or formats, such as digital twins, enhanced wallets; augmented, mixed, or virtual reality systems; and/or digital transaction interfaces embedded in or on physical goods or at a point-of-sale; and/or automation, orchestration and/or optimization (such as by AI) of offer and acceptance, contract terms, fulfillment, and other workflows involved in a transaction.

In embodiments, the engine 8500 may be configured to embed data about physical processes into financial products to improve risk and value assessment, assure the identity of transaction participants, validate provenance of physical information, and optimize product and information distribution. This may include sensor data, data collected from infrastructure elements (such as the environment of storage, transportation, sale or use of a product), data collected from operators or observers, market data (including reviews, surveys, ratings and recommendations), demographic data, and many others as disclosed throughout this disclosure and the documents incorporated herein by reference.

The engine 8500 may embed data about financial products into physical products, infrastructure, and processes. For example, in a project finance or reinsurance transaction, one or more parties can be informed by performance metrics and associated costs related to real assets. The engine 8500 may employ a blockchain to circumvent and democratize project finance and insurance. As such, the engine 8500 may provide insurance and project planning to one or more parties, thereby supplying real data that can be used to determine risk and risk management, e.g., as part of a reinsurance mechanism.

In embodiments, the engine 8500 may be configured to validate and/or authenticate data or specific types of software code before incorporating the data with a larger data set (e.g., personal data) or adding the code to a platform (e.g., validating software code). With the increased security issues such as identity theft and use of false online identities as well as malicious actors trying to hack or input viruses, there is a need for validation provenance of physical information. There is a need to use various external information (from user associated data, user's device associated data, or external data related to particular user). External data can be, for example, various personal data at any level such as home address, phone number, car, where is user born, SSN, etc. External information may be biometric. Such examples include, but are not limited to fingerprint, palm veins, face recognition, DNA, palm print, hand geometry, iris recognition, retina and odor/scent. The engine 8500 may identify information to be used from users and/or user devices randomly. The information may be a combination of both user data and user device data. Process of authentication may be checked frequently from users either randomly or for each transaction, thereby potentially eliminating the ability for a robot (e.g., script, program, RPA, AI, and the like) to falsify user data to be incorporated, e.g., in cases where the robot cannot be validated and, and may eliminate the robot user from attempting to communicate with the system, e.g., indefinitely.

By way of example, the engine 8500 may be configured to provide automobile dealers with data associated with vehicle maintenance, service intervals, costs, etc. based in part on real-time or downloaded data. The models may be fed into vehicle pricing, warranty costs, and risk assessments, extended warranty offerings, etc. conducted by auto manufacturers and dealers. Similar models can be applied to any connected device/product, where specific cost, types of risk, use cases, user profiles, and similar data and analysis models can be applied and priced to offer customized services that are much better than the standard question at the cash register and/or at an electronic point of sale, such as extended warranties, insurance options, and the like.

By way of another example, the engine 8500 may use embedded data to facilitate the availability of reduced auto insurance rates based on driving habits. The engine may make available and/or create independent data streams, and/or develop independent risk assessments and cost models, which in turn may create a new market and/or enhance existing markets warranty, purchase negotiation, insurance, and other services, as well as making these services more transparent. The engine 8500 may apply datasets and models to nested products or parts for more accurate cost and risk models, and may, in embodiments, add in customer input data collected from connected devices for richer data.

The engine 8500 may provide notifications to customers for maintenance, upgrades, services, etc. based on real-time status of the product/device. The engine 8500 may present and/or visualize options as cost-tradeoffs (e.g., risk, cost of replacement, etc.) associated with a product or service. The engine 8500 may provision related smart contracts with product users based on how a product is maintained, used, e.g., the type of data supplied, etc. Also, the engine 8500 may provide transparent consumer or other product ratings.

In embodiments, the engine 8500 may be configured to provide trustless disjointed data pools and/or disjointed data pools that meet high trust demand. Shifts in attitudes towards data privacy are causing a reassessment of the major institutions and a growing number of data regulations are requiring institutions to give back control over information to consumers. This creates an explicit trust gap that will drive fundamental reshaping of how individuals and businesses manage their data and creates an open opportunity about who may help them simplify and orchestrate this management: generally financial institutions are well-poised to play this role. Other than in a trustless environment (e.g., DLT) a trusted intermediary (e.g., financial institution) with high security standards will have a distinct advantage by helping customers manage access to disjointed (i.e., held with multiple different parties), highly sensitive data. Examples include consumer banks increasingly integrating with other apps and personalization services

In embodiments, the engine 8500 may be configured to provide proxies, i.e., “back doors,” into data sources. ISPs, exchanges, etc. will look for “back doors” or proxies to data sources that might become increasingly regulated and/or customer controlled. For example, the right collection of IoT data sources, aggregated intelligently, might tell one as much about a customer's behavior and interests as would historical data sets like surveys and POS data.

In embodiments, the engine 8500 may develop ways to automatically calculate performance metrics of a particular product based not only on its use, but how it is used in conjunction with other connected products in a home or personal environment. The engine 8500 may thereby produce a rich and valuable set of available data which can be part of an available data stream subscription asset.

In embodiments, the engine 8500 may facilitate gathering, sharing, marketing, transacting for, and/or securing aggregate and/or individual medical data. Overall healthcare relies on this data; for example, testing results with COVID are widely available through the test labs. This information has been central to the management of the deployment of treatment and disease management programs. For example, the engine 8500 may facilitate analysis of outliers for vaccine administration. There are small numbers of people who may develop side effects, and these individuals need careful medical study to discover if there may be clues to other risk factors. Individuals may share health information and/or become part of a study to find clues to additional risk factors. The engine 8500 may facilitate acquisition of HIPAA compliance and other privacy concerns

In embodiments, the engine 8500 may facilitate gathering, sharing, marketing, transacting for, and/or securing data used to determine effectiveness of a treatment program.

In embodiments, the engine 8500 may facilitate using pharmaceutical, supplements, devices, sales, demand data, etc. in geographic area to infer protected health data for a population. For example, if an area has increased insulin sales, it can be assumed that diabetes cases are higher in that area than average areas. The data may be obtained from manufacturers (e.g., via quarterly reports). Other types of data may be indicative of overall health of a population or demographic, such as profitability or revenue of “bad” for health products v. “good” for health products. For example, alcohol, nicotine, fast food, streaming services, etc. v. health food stores, gym memberships, etc. The engine 8500 may implement machine learning, AI, and/or intelligent agents to identify more latent products that correlate with “good” and “bad” health outcomes and use the identifications to infer health data of populations.

In embodiments, the engine 8500 may facilitate gathering, managing, and/or transacting of personal location data from cell phone traces. Personal location information can be highly sensitive, and increasing use of that data by, for example, social media communities, may lead to a counter-response to further limit use of that data. If cell phone location tracking data becomes constrained, or even barred, for some purposes, proxies may be needed for a wide range of location-based applications. The engine 8500 may create and/or manage proxies including one or more of ride sharing, delivery services, location-based promotions and advertising, navigation, routing, and the like. Proxies for the data may include aggregation and averaging of location data across time or groups of people, such as to provide a statistical prediction of the most likely location. The engine 8500 may determine locations by infrastructure, such as image classifiers, such as for recognizing public location events by camera, while keeping private location information secret. The engine 8500 may gather, analyze, and/or disseminate transaction data and/or metrics related thereto to provide insight into patterns of location, such as in-store purchases. Data about job location, school location, and the like can be used to predict location, including based on patterns.

In embodiments, the engine 8500 may facilitate managing and/or transacting for data from a visual edge and/or data inferred from cameras. The engine 8500 may gather information from camera data and extract and use the data without revealing underlying pictures. The data may be abstracted for specific purposes, thereby preserving privacy or regulated data and information. Cameras are everywhere and the ability to sell abstracted data may be used by users for, for example, trucks leaving warehouses, patrons visiting retail locations, foot traffic, assets moving inside facilities or mining/construction sites.

In embodiments, the engine 8500 may facilitate managing and/or transacting for universal data contracts that apply to online services companies.

In embodiments, the engine 8500 may include an obfuscation module 8510 configured to obfuscate aggregated, anonymized data. What is considered anonymized or blinded data is likely to change, and narrow, in the near future because data that has historically been blinded in isolation (such as by removing personally identifiable information [PII]), is now increasingly used in combination with other data sources, and when combined with other data, the aggregate contains sufficient information, and is so granular in some respects, that the anonymity is lost. For example, location data, occupational data, age data, and the like for a group of individuals may be anonymized, such as by removing names, birth dates, and the like; however, at some point the threshold is crossed when there is probabilistically, for example, only a single lawyer at location X who could have traveled from Y, is age Z and so forth, so that determining personal information via aggregated data can be accomplished by ascribing to that single lawyer all of the attributes contained in the aggregated data set for lawyers at location X, from Y of age Z, etc. This has lots of implications for basic privacy law compliance, such as with respect to HIPAA, European data privacy laws, and many others. For example, data brokerage practices are likely to change, as data brokers may run afoul of privacy regulations depending on how they are aggregating “anonymous” data. In embodiments, this may be handled by machine learning and other tools (trained by deep learning on outcomes, learning on labels or feedback, supervised learning, semi-supervised learning, training on expert human interactions (such as using robotic process automation, or other techniques), such as to automatically undertake under supervision, or to recommend how to do one or more of the following: partition data into partitions that satisfy threshold requirements for maintenance of anonymity, segregate sets of data or otherwise prevent combination of such data sets (or elements therein) to the extent that the data set tends to expose information that is required to be kept private; aggregate data sets into larger pools from which it is more difficult to infer private information; set thresholds of granularity (such as location groupings) at sufficiently low settings such as to make it sufficiently difficult to infer specific information that is required to be held private; test data sets (such as with respect to parameters of aggregation, granularity, partitioning, and the like) to produce metrics of security and/or vulnerability to privacy invasion; introduce elements that increase uncertainty as to whether individual information can be correctly inferred (such as fictional names, occupations and the like that are unlikely to diminish performance by systems that are undertaking appropriate uses of the data set, but that would tend to interfere with uses that are seeking to infer private information); and the like. These actions can be applied to various data sets, data pools and types that contain privacy-protected information or that should not be combined for other reasons. In embodiments, a set of methods, systems and models may be provided, which in each case may be used as a foundation or seed for development of a set of automated agents (such as through robotic process automation), to undertake various actions that may support or enable more sophisticated and/or compliant usage of aggregated data, such as to: predict what missing data sets or types would be needed in order to approximate, or to directly infer identifying information or other sensitive attributes of an individual person, a type of person of interest, or the like; provide a set of incentives, or present appropriate disclosures, terms, conditions and the like, in order to induce a person of interest to consent to inclusion of personal data in data sets and/or to consent to aggregation of personal data into larger data sets; refine or regulate usage of aggregate data sets, and permissions thereof, such as to refine for what purposes aggregate data may be used when there is some risk of inference of personal or private information (such as where aggregate data is permitted for medical research, but not for marketing); and others.

Increasingly, a wide variety of activities and systems involving personal data sources, such as targeted advertising, workflows involving consumer IDs, web cookie acceptance, location data gathering/retention, health care activities, human resources activities, website utilization, online personal data gathering, surveys and research activities, are subject to regulation. The EU has been leading the world in passing regulations governing which types of data businesses can collect. Some types of data are allowed with consent by the consumer, while others (such as data regarding minors) are prohibited altogether or require consent by a parent or guardian. Businesses and advertisers may use gamification, promotional offers and/or reward/loyalty program strategies to incentivize consumers to give consent to having their browsing habits tracked by an ad/consumer ID and/or have data already linked to their ad/consumer ID be used to modify their web browsing and/or app using experience. For example, a consumer may be offered credits for browsing one or more websites while having personalized data collection enabled. These credits may be redeemable by the consumer for digital and/or physical goods. Businesses and/or websites may collaborate with one another to offer unified incentive systems across each of them.

Further examples of data which may be obfuscated via the obfuscation module 8510 may include: the signature of power usage across home/business/enterprise premises and/or systems from the panel (such as with the ability to see each appliance/computer/AC-system/generator come online, such as based on the signature of these premises and/or system activities existing in the waveform of AC consumption relative to other units); wearable data (such as by using augmenting data from infrastructure and cameras to serve as proxies for activity and energy, etc.); ethnicity and/or race data (which may be used to anonymously identify these groups of people and trends related to transactions they pursue/involved in and/or how they may be impacted by transactions in a variety of fields); political affiliation and/or religious/philosophical affiliation data (such as by determining whether associations between these groups of people relate to any number of viewpoints from political/religious/philosophical affiliations); social media data (such as by using one or more AI agents to classify or otherwise characterize social media presence of an individual and/or a cohort around the individual); medical or health data (such as by inferring a diagnosis from a combination of image or camera data with other data, such as wearable device data, shopping data, behavioral data, or the like); and many others. While there may be benign or beneficial uses of such inferences, there are potentially harmful effects as well, such that many users may wish to be shielded from usage of such inferences except where they are aware of the usage and have given consent.

In embodiments, the engine 8500 may facilitate one or more processes by which the obfuscation module 8510 may process and/or analyze one or more data models for one or more markets, goods, services, users, market makers, market datasets, etc., to determine data instances, aggregates, etc. of the data models that may be sensitive for regulatory purposes. The obfuscation module 8510 may, for example, determine one or more datasets, instances, aggregates, etc. that may be or include personally identifiable information relevant to HIPAA, financial privacy regulations, European data privacy regulations, California data privacy regulations, etc. The determination of personally identifiable or otherwise sensitive information may be performed via one or more rule-based systems and/or intelligent systems (e.g., AI, ML, ANN, intelligent agents, via proxies, patterns, teachings, etc.). For example, the obfuscation module 8510 may include an artificial neural network configured to train on one or more datasets and thereby learn types of data that are sensitive. The obfuscation module 8510 may then identify sensitive data and perform one or more obfuscation operations and/or classify or flag the data as sensitive data.

In embodiments, the engine 8500 may facilitate one or more processes by which the obfuscation module 8510 may include an obfuscation module configured to perform one or more obfuscation operations to obfuscate data identified as, determined to be, flagged as, and/or classified as sensitive data. The obfuscation operations may be or include one or more of redaction, replacement, addition (such as of fictional elements), partitioning, separation, augmentation, aggregation, noise addition, random rounding, and/or encryption. Redaction may include, for example, eliminating identifiable elements from datasets and/or models. Replacement may include, for example, replacing sensitive data with proxy data, random data, hypothetical data, and/or anonymized data representative of the replaced data. Partitioning may include, for example, adjusting partitions, increasing or decreasing number or granularity of partitions, and the like. Separation may include, for example, separating data elements that are sensitive, such that they are excluded from aggregation. Augmentation may include tagging data elements that are particularly sensitive, adding metadata to data elements, or the like, such as to flag them to aggregation programs, to set parameters for aggregation, to set policies for aggregation, or the like. For example, data elements in a data set may be augmented with a set of policy metadata governing how those elements are permitted to be used, such that data aggregation systems or other systems may consume the policy elements and undertake aggregation consistent with the policies. In embodiments, policies may be maintained and automatically updated by a policy engine, such that metadata elements are automatically updated when policies change, such as governing rules of a region, nation, state, or other entity. Aggregation may include, for example, aggregating data to meta-level content from which determining personally identifying information is difficult or impossible. Noise addition may include, for example, adding an amount of noise to the sensitive data such that the sensitive portions of the sensitive data are difficult and/or impossible to identify, trace, determine, parse, etc. Random rounding may include, for example, randomly rounding values, including totals, either up or down (e.g., to a multiple of ‘5’ or ‘10.’) To understand randomly rounded data, one must be aware that each individual value is rounded. As a result, when the randomly rounded data are summed or grouped, the total value may not match the individual values, since totals and sub-totals are independently rounded. Similarly, percentages calculated based on rounded data may not necessarily add up to 100%. Encryption may include, for example, applying one or more cryptographic processes to the sensitive data such that the sensitive data cannot be accessed, read, modified, marketed, etc. by untrusted parties.

In embodiments, the engine 8500 may facilitate one or more processes by which the obfuscation module may perform the aggregation obfuscation operation according to one or more aggregation hierarchies having a plurality of aggregation levels. The obfuscation module 8510 may determine one or more aggregation levels that may be appropriate for an aggregation obfuscation operation according to rules, regulations, preferences, etc., that are applicable to and/or appropriate for the sensitive data being aggregated. Aggregation levels may include, for example, ZIP Code +4, ZIP code, neighborhood, city, state, county, province, department, country, global region, etc. Determination of appropriate aggregation level for a particular instance of sensitive data may be performed by one or more of the intelligent systems based on one or more attributes of the sensitive data. This may include determination by a robotic process automation system that is trained on a training set of interactions by a set of human experts and/or by a deep learning system. Aggregation levels may be tested, such as by a deep learning system or other learning system that is trained to attempt to infer sensitive data from data sets, including by seeking additional data sets that, with further aggregation, facilitate inference of private information. Such as testing system may provide a set of recommendations, or inform a model, such as one that indicates relative risks for permitting aggregation of a given type of data set, a particular data set, a level of granularity, or the like.

In embodiments, the engine 8500 may facilitate one or more processes by which the obfuscation module 8510 may use one or more intelligent systems (e.g., AI, ML, ANN, DPANN/MEANN, intelligent agents, via proxies, patterns, teachings, etc.) to determine whether sensitive data on which one or more obfuscation operations have been performed has been satisfactorily obfuscated. Upon determining that the sensitive data has not been satisfactorily obfuscated, the obfuscation module 8510 may perform one or more further obfuscation operations on the sensitive data. For example, the obfuscation module 8510 may determine that data includes personally identifiable information that violates one or more regulations. The obfuscation module 8510 may perform one or more obfuscation operations on the data to obfuscate the personally identifiable information via the obfuscation module, and then determine whether the personally identifiable information remains determinable within the data after the obfuscation operation has been performed. If the personally identifiable information remains determinable, the obfuscation module 8510 may perform one or more further obfuscation operations via the obfuscation module on the data and repeat the determination process.

In embodiments, the engine 8500 may be configured to provide tools to help customers make better financially linked decisions. White-labeled players across industries are driving standardization of, and margin compression in, core product lines; in this environment, advice and ancillary services can become key differentiating factors, helping customers conveniently make important decisions. Ecosystem connectivity will help institutions access non-standard data about customers to further tailor and improve offerings. Institutions can work with ecosystem partners to deliver personalized tools, recommendations, and access to ancillary services to help clients make non-financial decisions that are linked to their financial well-being. Examples include consumerization of business, and consumer examples such as automated financial tracking, credit awareness, subscription optimization, couponing, recommendations, and the like.

In embodiments, the engine 8500 may provide tools to help commercial customers and consumers alike make better financially linked decisions. On the consumer side, a consumer may provide spending data and/or investment data as well as non-financial data to the tool, which may then analyze non-financial data with spending data and/or investment data to provide recommendations that improve the financial situation of a user. For example, a customer may provide a monthly spending report, which may show a monthly car lease payment, mortgage payments, etc. The customer may have also provided non-financial data, such as travel plans, vacation days, work travel, lease agreements. The tool may run models that optimize a monetary parameter given the information provided by the user. By way of further example, the tool may determine that the consumer should either fly or rent a car rather than drive their car to their vacation location, as the mileage costs may exceed the price of a flight or a rental. In another example, the tool may recommend the best dates that a user should request for vacation and/or locations to travel to so that the user may reduce the cost of a vacation. In another example, a user may provide information relating to their television viewing habits as well as their subscription services, and the tool may determine a schedule when the user may cancel certain subscriptions and/or add new ones to ensure that they are watching the content they like, but not paying for subscriptions that the user does not need at a particular time.

For commercial users, the engine 8500 may identify measures that an organization may undertake to reduce burn rate. For example, if multiple business units are subscribing to different but overlapping services, the tool may recommend that the business units use a different product that covers all the services or may recommend that one unit switch service providers to another service provider. In this example, the tool may calculate the savings over a period of time to show the overall cost to the business by accepting the recommended action. In another example, an organization may provide addresses of its employees (or general locations), a role/team of each employee, and public calendar items of the organization/employees. The tool may identify employees who may provide more output if they are allowed to work from home, flex scheduling for employees in the office by team/meeting schedules, or the like. Using this tool, the organization may improve productivity for certain employees or teams, while reducing their office space which provides financial savings.

In embodiments, in order to identify financial outcomes linked to non-financial actions, the engine 8500 may employ different means of identifying the links. For example, the system may include an “expert-sourced” library that provides non-financial actions that can be performed in different scenarios to obtain better financial outcomes. Additionally or alternatively, the system may employ machine-learning techniques to identify more latent non-financial actions that are tied to verifiably “better” financial outcomes. In these embodiments, the system may use data from a collection of different sources (which may depend on the “class of user”), where the data includes financial signals as well non-financial signals. The engine 8500 may use appropriate AI/ML algorithms, such as those described herein, to identify the non-financial signals that are most strongly correlated with the positive financial signals and/or the negative financial signals. The identified signals and/or correlations may be applied into AI systems to assist clients in making decisions. For example, a user may provide non-financial data to the engine 8500, and the engine 8500 may identify scenarios where the user may take certain non-financial actions that were determined to be linked to positive outcomes and/or non-actions that could be taken by the user to avoid negative financial scenarios.

In embodiments, the engine 8500 may link data gathered about a customer in one market to a related market. For example, data related to customer preferences about a house may be extended to a marketplace for home design services.

In embodiments, the engine 8500 may project long-term financial outcomes for decisions that provide a clearer “lifetime projection” across outcomes (e.g., by factoring in the costs of emergency care for a pet or non-routine maintenance for a system, averaged across a population and with indicators of the “worst case” situations). As such, the engine 8500 may help users understand “ratchet” effects, or implications of commitment or situational dependence on one or more market conditions.

In embodiments, the engine 8500 may be configured to facilitate securitization of future revenue streams. Securitization of future revenue streams allows companies to grow without shareholder dilution by financing their recurring receivables, provides for capital infusion by exchanging predictive, recurring revenue streams in exchange for discounted advance funding, and allows companies an alternative to the significant discounting found in other forms of single payment used as an inducement for customers to switch from recurring monthly to single payment. The engine 8500 may facilitate offering an instant cash advance against the full annual value of a company's subscriptions or source of recurring revenue. Examples of sources include real estate, SaaS or any as-a-service business model, advertising slots, and any other suitable business sector or model that allows for monetizing long term revenue streams without offering discounted incentives.

In embodiments, the engine 8500 may automatically configure a set of smart contracts to calculate a revenue share related to a set of assets and allocate a fraction, such as fixed, formulaic (e.g., based on time or other variables, including dynamically determined) to a distributed ledger, whereby the revenue share is redeemable, such as based on a token that represents the right to redeem the revenue share. The revenue share calculation may be based on available data, including accounting data or utilization data (e.g., as computational cycles used if the asset is a server, views or clicks if the asset is an advertising spot, salary/bonus for an individual, royalties for an item of IP, rent for an item of real property, dividends for securities, etc.). A token representing the redemption right in the smart contract may trade in a marketplace, the price of which may reflect a set of parties' predicted value of the future revenue stream. The engine 8500 may employ AI, RPA, intelligent agents, or a combination thereof, to operate on disparate data sets across markets to predict future revenue, adjust initial pricing, recommend trading activities, automate arbitrage activities, aggregate positions (e.g., to hedge risk and/or optimize a risk/return profile), and govern trading rules with respect to the token. Custody of assets may be governed by a secure set of automated, custodial agents. Sets of assets may be virtualized into working groups, with revenue share being allocated at the group level.

In embodiments, the engine 8500 may facilitate one or more processes by which a basket of revenue shares may be constructed and automatically maintained by an intelligent agent, such as a basket of rents, royalties, dividends, interest payments, annuity payments, and others.

In embodiments, the engine 8500 may facilitate one or more processes by which an AI system may optimize the basket, such as based on a target risk/reward profile or asset allocation, feedback on outcomes, (e.g., yields), contextual data (e.g., on market conditions, asset conditions, process states, and other data about marketplace entities), and other factors.

In embodiments, the engine 8500 may perform contract enforcement and dispute resolution services in cross-market environments, such as environments where physical assets or revenues from physical assets are involved in a smart contract or where revenues are received in one environment while those entitled to the revenues (and the smart contract) operate in a different environment. The engine 8500 may perform covenant enforcement, where covenants may apply to multiple parties of an agreement, may monitor for compliance, may determine that there is a breach, and/or may determine that one or more breaches have been cured. Examples of cross-market environments that may involve disjointed data include involuntary collections, collateral repossession and disposition (e.g., mortgage foreclosures, auto repossessions, recoveries from sources not directly involved in the smart contract (e.g., deficiency balance collections), collections from co-applicants or guarantors or credit insurers, tax calculation, collection, and remittance, and the like.

In embodiments, the engine 8500 may facilitate enforcement in an environment where multiple parties contribute to creating a token or series of tokens, such as borrower and guarantor or co-applicants for a loan. Such environments may include cases where multiple parties pool their assets (or revenue streams) in a distributed environment in order to gain scale and efficiencies (lower pricing), such as lenders pooling resources. Further examples include transactions including credit insurance and other credit enhancement providers, such as guarantors and/or unrelated parties. The insurers, enhancement providers, guarantors, etc. may receive payment corresponding to risk.

In embodiments, such as those including structured finance environments, the engine 8500 may create a token or series of tokens based on an asset or asset pool. The token or series of tokens may be broken into credit tranches (e.g., AAA, AA, A . . . tokens) and marketed at different price points (and assume different risk levels) with the lower credit quality tokens dependent on the higher credit quality ones.

In embodiments, the engine 8500 may be configured to function as a trusted data steward, thereby ensuring secure transfer, use, and exchange of only necessary information between trusted parties. The engine 8500 may provide a data sharing platform employing one or more of blockchains, smart contracts, tokenization, double-blind methodology, and smart encryption. The smart encryption may be configured such that the data sharing platform or one or more users, clients, and/or parties may monitor service providers to ensure data is being used and stored appropriately, such as according to one or more contracts, smart contracts, laws, regulations, and/or the like. The data sharing platform may link to one or more financial institutions and/or other stakeholders and use data therefrom to effectively monitor service providers. The data sharing platform may secure data transmission approaches, such as 5G and IoT, employ one or more authentication models, facilitate exchange and consent management, and/or provide continuous authentication of parties (e.g., by using extended data sets).

In embodiments, the engine 8500 may perform data minimization with regard to the collection of personally identifiable information. The engine 8500 may use transaction history and related metadata, such as in a distributed ledger, to authenticate a person, entity or other transaction source (e.g., a virtual entity), thereby reducing the need for the solicitation, transmission, and/or storage of additional sensitive information. The engine 8500 may authenticate for a current transaction using information based on a prior transaction, such as information stored in a ledger. Devices associated with a transaction entity may be authenticated, at least in part, for a current transaction using information based on a prior transaction, such as information stored in a ledger.

In embodiments, the engine 8500 may facilitate one or more processes by which authentication may itself be a transaction recorded in a ledger. For example, the engine 8500 may justify a payment processor based on a prior authentication in collecting a reduced set of personally identifiable data for a current transaction.

In embodiments, a data purge may be a ledger transaction. For example, the engine 8500 may create an audit trail including data that an entity in a transaction chain had, but no longer stores, such as sensitive data that may be required to maintain in the ledger only for the purposes of processing a transaction. The engine 8500 may establish an audit trail for post-hoc verification that data collection was appropriate in scale and substance (e.g., only required and pertinent information was collected; unnecessary data was not stored, and the like).

In embodiments, the engine 8500 may use trusted data and/or data steward processes to rate entities that are would-be parties to a transaction. Entities may be at the device level, such that the rating may be a surrogate of how trusted or not trusted a device is based on its prior transaction/data collection record. The rating may be used as a selection criterion (including automated) for allowing participation of an entity, device and the like in a transaction, or to collect data, collect a particular type of data, and the like, for example to determine a reputation measurement derived from the blockchain or other transaction and data collection history.

In embodiments, the engine 8500 may use trusted data and/or data steward processes to determine potential transaction pathways available for a given transaction. For example, pathways may be determined for a transaction involving purchasing cryptocurrency using fiat currency from a banking institution and transferring the cryptocurrency to a personal wallet and to a vendor from the personal wallet to affect the transaction. The chain of transaction and/or data collection may be viewed as a single transaction for the purpose of rating the security, necessity of the contemplated data collection, and the like.

In embodiments, the engine 8500 may set a threshold that must be met in a rating to proceed with a contemplated transaction.

In embodiments, the engine 8500 may determine a measure of data collection behaviors, and/or may push behaviors, tracking mechanisms and the like.

In embodiments, the engine 8500 may include a verifiable action token module 8514 configured to create, manage, and/or facilitate the creation/management of verifiable action tokens. The verifiable action tokens may be tokens that are linked to data (e.g., operational, financial, etc.) and can be accessed securely to ensure agreed upon actions are taken. With the rise of alternative asset classes (e.g., crowdfunding, real estate), investments tied to verifiable actions provide investors additional transparency for their investment. Equity and/or debt tokens may be linked to real-time sources of data. The data sources may include, for example, IoT data, operational spending data, and resource allocation data. Actions may be taken based on verifiable triggers, such as regulatory, legal, financial, buying events, selling events, penalties, etc. In some embodiments, the verifiable action token module 8514 may facilitate management of custody, and/or trading, of verifiable tokens.

In embodiments, the engine 8500 may facilitate one or more processes by which the verifiable action token module 8514 is configured to implement verifiable action tokens with assets such as securities, investments, tangible assets, intangible assets, and components. The verifiable action token module 8514 contains a GUI-enabled interface that allows an owner of a security, an investor, a party to an M&A and/or a contributor to or investor in a supply chain to acquire, view, manage, and make transactions related to verifiable tokens for their assets. The owner may view their tokens and see which assets are related to the tokens. The owner may also view any smart contracts related to the tokens, and logs of past, current, and future actions taken according to such smart contracts. The actions may include related triggering events, which may also be displayed with related metrics. The metrics may be pulled from databases and real-time data sources. The databases and real-time data sources may include IoT sensor data, AI predictions and evaluations, operational spending metrics, resource allocations databases. A GUI interface may be provided for transferring custody of the verifiable tokens, such as via a marketplace and/or via private transactions. The tokens may have associated rewards and/or penalties, the rewards and/or penalties triggering automatically according to encoded triggering events, smart contracts, innate attributes, templates, etc. The verifiable action token module 8514 may include templates for types of securities (stock, bond, etc.), transactions (M&A, short, auction, etc.), assets (tangible, intangible, IP, inventory, security, etc.), and/or overseeing bodies (regulatory, insurance, etc.). The verifiable action token module 8514 may include a data stories system and related AI system configured to present the user with a human-readable data story in relatively plain language related to their verifiable tokens. The verifiable action token module 8514 may also include a marketplace integration system that allows the user to make transactions related to the tokens on one or more marketplace and/or auction platforms, or within one or more blockchains/distributed ledgers.

In embodiments, the engine 8500 may facilitate one or more processes by which the verifiable action token module 8514 may associate securities, such as stocks and bonds, with verifiable tokens recorded on a ledger. The recordation on the ledger may reduce the fees associated with the middlemen of a traditional securities exchange, as no middleman is required to maintain the integrity and value of the securities-associated tokens. The tokens may be signed, verifiable as unique and valid, and even have logic and/or smart contracts associated therewith. The logic and/or smart contracts may include automatically triggered events for transactions such as shorts. IPOs and other securities creation events may be managed via tokens and logic/smart contracts associated with the tokens.

In embodiments, the engine 8500 may facilitate one or more processes by which the verifiable action token module 8514 may facilitate backing investments of investors, such as private investors and VCs, by verifiable tokens. The verifiable tokens may be generated for businesses in which investors have invested, such as in assets of the business, or partial ownership of the business. Smart contracts and other logic may be employed with regard to the investment agreements. For example, an investor may receive an automatic payout upon verification of revenue, sale, license, etc. by the invested-in business.

In embodiments, the engine 8500 may facilitate one or more processes by which the verifiable action token module 8514 may manage merger and acquisition transactions via verifiable tokens recorded on a ledger. The tokens may be associated with assets of an entity to be acquired. The assets may include tangible assets such as inventory, equipment, infrastructure, etc. The assets may also or alternatively include intangible assets such as intellectual property, debts, securities, deeds, and liabilities such as contractual obligations, regulatory obligations, insurance obligations, etc. The verifiable action token module 8514 may associate smart contracts and/or logic the tokens to verify the integrity of each and facilitate transfer from one entity to another as the merger or acquisition transaction is completed.

In embodiments, the engine 8500 may facilitate one or more processes by which the verifiable action token module 8514 may tokenize manufacturing and/or supply chain systems by verifiable tokens. The tokens may be associated with each of products produced, factory machines on a manufacturing floor, units of inventory in warehouses, or transport vehicles such as robots, trucks, trains, ships, etc. Different businesses that participate in a supply chain may transfer verifiable tokens to one another via the verifiable action token module 8514 as resources are expended, materials and/or products are moved, contractual conditions are met, etc. AI systems of the platform 100 may be configured to automatically predict and/or validate conditions in manufacturing and/or supply chain environments. The AI systems may tokenize predictions and validations. These tokens may be recorded, traded, and may even have value in secondary markets.

Examples of verifiable action tokens include green action tokens, production tokens, contract tokens, governance tokens, and energy tokens. The green tokens may include tokens to not cut down trees, tokens to not drive vehicles, tokens to use public transit, verified carbon capture tokens, verified non-pollution tokens, tokens for solar power usage, recycling tokens, weekly shipment/fewer packages delivered tokens, minimum plastic usage tokens, tokens for not dumping industrial effluent, and tokens for planting saplings and/or trees, and the like. Production tokens may include tokens for production of a product unit, tokens for mining of a mineral/metal, and the like. Contract tokens may include tokens for satisfaction of a payment obligation, tokens for satisfaction of a covenant, tokens for compliance with a permit's limitations, tokens for compliance with construction codes, and the like. Energy tokens may include tokens for energy usage within limits, tokens for saving energy, and the like. Further examples of tokens include guarantor action tokens, such as tokens for bearing risk and/or responsibility if a guaranteed action does not take place. Further examples of tokens include tokens verifying that one has not used bots and/or scripts to mass purchase/scalp a product having limited stock for the purpose of reselling on a secondary market, tokens verifying that one has not sold a product to more than one buyer 8506, tokens verifying that one has not sold to a prohibited buyer 8506 (such as a politically/statutorily prohibited foreign or criminal buyer 8506), tokens verifying that a politician or business executive has not taken money from illegal or unconscionable sources, tokens verifying that a politician has not illegally collaborated with a private business for marketing gain of the business or financial gain of the politician in exchange for political favors, and the like.

Further examples of verifiable action tokens include tokens for using an amount of electricity, tokens for air conditioner settings, tokens for heating settings, tokens for using an amount of water, tokens for length of shower, tokens for amounts of emissions, tokens for not eating meat, tokens for not slaughtering animals, tokens for plastic usage or non-usage, tokens for recycling, tokens for creating an amount of garbage, tokens for refraining from flying on planes and/or private jets, tokens for washing hands, tokens for wearing masks, tokens for being vaccinated, tokens for remaining at home and/or indoors, tokens for having fewer than an amount of people in a residence and/or on a premises, tokens for verifying crowdfunding projects and/or reaching landmarks thereof, tokens for attending school and/or classes, tokens for completing homework, tokens for performing community services, tokens for not smoking, tokens for not smoking in particular locations, public health tokens issues based on diet, speeding, not drinking, etc., tokens for managing consumption of clothing, potable fluids, foods, space, etc., tokens for mileage per week of transit, parental tokens based on spending time with children, reading with children, spending time outdoors with children, etc., philanthropic tokens based on performing charity work and/or contributions, tokens for taking medication, such as during a testing trial or while undergoing a therapy program, tokens for social media interaction, tokens for call center workers, tokens for calling a call center, tokens for making a sales contract, tokens for contacting customers and/or prospective customers, tokens for means of contact, e.g., voicemail, email, etc., tokens for meeting with persons, tokens for reducing disease spreading risk, tokens for potential interaction tracking, tokens for conditional probability of related actions, tokens for dispute resolution, tokens for proof of stake, tokens for insurance verification, tokens for cardiovascular activity, e.g., exercise classes, jogging habits, etc., tokens for servicing of warranties for cars, houses, rental properties, and the like, tokens for partaking in marketing activities, e.g., social media post interactions, tokens for employment conditions, tokens for college admissions criteria, tokens for community service work, tokens for law enforcement activities, tokens for maintenance of public spaces, and the like.

In embodiments, the engine 8500 may be configured to provide borderless asset enablement. Data is an asset and there are regulatory, compliance, security, cost and other reasons for data to remain in-house or not be moved outside of certain jurisdictions or locations. As the data economy grows with increased sharing of data, there needs to be a mechanism that allows data to be transacted and exchanged across borders, thereby becoming borderless. The engine 8500 may provide an asset-backed tokenization platform. The engine 8500 may provide connecting data owners with nodes to DLT networks via the asset-backed tokenization platform. The DLT networks are connected to other DLT networks via the asset-backed tokenization platform. As such, data is moved as a transaction on a DLT network as opposed to direct exchange. Architecture for borderless transactions may be one or more of proof-of-work, delegated proof-of-stake, bonded proof-of-stake, pure proof-of-stake, etc. In some embodiments, the asset-backed tokenization platform may provide decentralized financing of other non-traditional assets, e.g., balance sheets, knowledge, brand, workflows (crypto mining, verifications, oversight), and the like.

In embodiments, the engine 8500 may facilitate data to be transacted and exchanged across borders, including jurisdiction, industry, location, and the like. The engine 8500 may provide for a curated and/or regulated nested data pool with provenance that includes parts and assemblies, single and multiple users, etc., that can support transactions for analysis that support anonymous, personal, aggregated, fractional, specific, or other types of arrangements.

In embodiments, the engine 8500 may facilitate one or more processes by which borderless transactions may be provided according to one or more architectures, such as proof-of-work, delegated proof-of-stake, bonded proof-of-stake, pure proof-of-stake and/or any other suitable architecture.

In embodiments, the engine 8500 may facilitate decentralized financing of non-traditional assets, such as balance sheets, knowledge, brand, workflows (crypto mining, verifications, oversight, etc.).

In embodiments, the engine 8500 may facilitate protection of intellectual property.

In embodiments, the engine 8500 may be configured to perform one or more market-making enablement operations. Individual market participants or member firms of an exchange may buy and sell securities for their own accounts, at prices displayed in the exchange trading system, with the primary goal of profiting on a bid-ask spread (e.g., the amount by which the ask price exceeds the bid price of a market asset). Enabling detailed price data and price discovery to establish a fair price that satisfies both buyers 8506 and sellers 8508 with detailed data. The market-making enablement operations may include one or more of enabling fractional ownership, improving auction/trading mechanisms, and asset linking. Enabling fractional ownership may include, for example, moving from a bid process that enforces a winner-take-all outcome to fractional ownership, the fractional ownership process supporting buying and selling shares of illiquid assets. Improving auction/trading mechanisms may include, for example, facilitating trading of illiquid assets by providing connections to digitalized markets, enhancing trading of illiquid assets with emerging technology (e.g., AI, distributed ledgers, smart contracts, etc.), aggregating liquidity, and enabling new ecosystems. Asset linking may include, for example, establishing, managing, and/or facilitating strong information flows about physical and/or financial statuses of assets.

Examples of market makers include brokerage houses or traders that provide trading services for a marketplace with a goal of keeping financial markets liquid. Market makers may be or be enabled by artificial intelligence and/or intelligent agents. A market maker may be an individual trader, such as a cryptocurrency trader.

In embodiments, the engine 8500 may create liquidity in fragmented markets. For example, a market for trading future price of organic bean sprouts, and/or a market for trading future price of organic carrots. The engine 8500 may relate the prices of the organic bean sprouts and the organic carrots to one another, and generally related the prices of the sprouts and the carrots to the overall price of vegetables via one or more market-making operations.

In embodiments, the engine 8500 may facilitate cross-market transactions. For example, the engine 8500 may facilitate carbon trading (such as paying owners of trees not to cut them down), and/or encourage personal behavior (such as not to drive car or to only eat vegetables). The engine 8500 may also or alternatively allow one or more guarantors or insurers to bear costs of actions taken.

In embodiments, the engine 8500 may facilitate creation of liquidity in illiquid markets. For example, market makers may take large positions and hold them for longer periods of time to manage the liquidity of markets via one or more market-making operations. Further examples include the selling of super yachts or art, where there is a very limited market and buyers 8506 are very limited. In such markets, buyers 8506 and/or sellers 8508 may find themselves holding positions in large expensive vessels or pieces that are difficult to sell. The engine 8500 may facilitate sharing of fragmented ownership of the vessels or pieces, thereby creating liquidity in the market.

In embodiments, the engine 8500 may facilitate making of markets across time zones, such as within a group of cryptocurrency markets where the securities can move between time zones. For example, the engine 8500 may allow a market maker to move the token between markets in different time zones to manage liquidity and price stability.

In embodiments, the engine 8500 may facilitate the making of markets in markets having slow trading times. For example, in a housing marketplace a market maker may use the engine 8500 to buy and sell houses immediately, such as wherein a seller 8508 creates a position where there is a continuous availability of inventory and a potential for immediate resale of the property.

In embodiments, the engine 8500 may facilitate trading between market makers in fragmented markets. The market makers may collaborate via the engine 8500 tooling to ensure that the market makers are providing liquidity and are not driving the overall market position. For example, in a fragmented crypto marketplace with multiple securities, the market makers may collaborate on trades to manage liquidity via the engine 8500. The engine 8500 may then introduce liquidity as a commodity or metric that can be measured, and the value associated with these liquidity producing activities are valued by the market and can be communicated between market makers.

In embodiments, the engine 8500 may facilitate trading between AI-based market makers. AI-based market makers are increasingly becoming a central part of managing the marketplace and creating liquidity. AI engines can be subject to adversarial neural network attacks and other information attack mechanism to force loss making positions, rather than creating liquidity. For example, an AI agent may be responsible for management of liquidity in an extremely high fragmented marketplace for trading cards. The challenge is that trading cards have many types, and each has an associated value (e.g., individual cards may have a value of hundreds of thousands of dollars). The AI agents can access the quality of the card via the engine 8500 and establish liquidity in trading in part or whole of a card providing for verifiable trading events and reliability of trade.

In embodiments, the engine 8500 may enable market makers to find price in a highly distributed marketplace. Establishment of price in a highly distributed market may require creation of indices that span multiple markets and allow for management of rational (if markets can be rational) pricing levels. For example, the engine 8500 may facilitate analysis of market functions in indices. The indices may include multiple securities and a basket analysis of price of the securities. In a highly distributed marketplace, the indices may need to be vastly more complex providing for assessment market positions and variations. The engine 8500 allows the market maker to manage the indices and ensure that the indices are stable and price fluctuations are within reasonable market boundaries.

In embodiments, the engine 8500 facilitates community market makers and market making by consensus. Market making by consensus allows a social media based market maker to create community pools of resources across a social network, thereby creating liquidity in a broader market, thereby resulting in a decentralized set of arbitrage opportunities. For example, in a cryptocurrency marketplace, there is a potential for a group of individuals to collaborate to maintain liquidity in the marketplace. The collaboration may require each member to contribute capital to a trusted market maker that manages positions and shares gains (or losses).

In embodiments, the engine 8500 may facilitate market makers to manage reinsurance. Market makers may have reinsurance companies behind them while the market makers take market positions that enable the establishment of true liquidity while having risk levels managed by third parties. For example, a futures market in cryptocurrency tokens for pork bellies may have a high-risk exposure to future climate events. The reinsurance company can stand behind the high-risk exposure via the engine 8500, thereby providing for a price guarantee in the event of a climatic disaster impacting pork belly prices.

Cross markets are a natural and powerful way of market building a cohesive and real-world marketplace. By linking markets together, cross market operations create an environment where smaller marketplaces become viable and efficient. For example, a new home housing marketplace and a marketplace for plumbers may be linked via cross-market operations. The new housing creates demand for plumbers, and a trader may recognize and analyze the demand via the engine 8500. The trader may create cross market values for the localization of plumbing services that are associated with marketplaces for the construction of new home units.

Some common factors in the cross-market enablement include arbitrage and international market management. Traders may seek out arbitrage opportunities via the engine 8500, as the arbitrage opportunities often represent one of the best ways of building value. The engine 8500 may employ machine learning and/or AI/intelligent agents to identify opportunities for the trader to find and drive value through the act of buying and selling in both marketplaces. These actions drive liquidity in both marketplaces as traders drive volume and establish consistency of price. With assets that span nations, there is a potential for international marketplace activities. For example, the engine 8500 may identify and/or measure an amount of human resources required for a build of a new product. A marketplace that spans nations and is able to handle the complexities of currency exchange in the buying process can enable buyers 8506 to establish a price for goods that combines currency exchange considerations with the ability to deploy local resources via the cross-market operations. Further traders may seek arbitrage activities against the currency fluctuations. The international cross-market operations may include identifying and/or managing regulatory properties, roles for AI-based markets, globalization factors, time zone management, and liquidity across national markets.

In embodiments, the engine 8500 may facilitate investing and/or market-making in a human resources asset, such as in finding, managing, gaining, and/or allocating manpower for manufacturing, sales, service performance, and the like. The engine 8500 may perform cross-market operations such as improving auction/trading mechanisms, asset linking, performing human asset equalization, enabling investment in a person, and/or representing one or more human assets as intelligent agents and/or digital twins.

In embodiments, the engine 8500 may facilitate managing risk (with human or other assets) based on performance, such as via testimonials based on verifiable performance data and metrics. The testimonials may be created over time and/or augmented by risk insurers. The testimonials may be provided as a service to a range of newer platforms.

In embodiments, the engine 8500 may facilitate representing people as digital twins, investing in human capital, and assisting with managing human capital as part of an investment strategy.

In embodiments, the engine 8500 may facilitate development of human capital, such as by gathering data related to and quantifying and/or qualifying impacts of education and/or experience human capital. For example, the engine 8500 may gather data relating and quantify and/or qualify the impacts of different skills sets on risk and insurance mitigation. If a team is lacking skill in regulatory governance, the 8500 may identify whether there is a real risk to regulatory initiatives. By way of further example, if there is a skills shortage, the engine 8500 may identify projects that could provide training experience to allow for human capital development.

In embodiments, the engine 8500 may be configured to perform order matching via an order matching system. The order matching system is an electronic system that matches buy and sell orders for a stock market, commodity market or other financial exchange. When market making, the way in which order matching operates can be crucial to how firms market match.

In embodiments, the engine 8500 may facilitate matching orders by considering price, timing, and/or quantity of goods and/or services. The engine 8500 may employ traditional matching, price-time-priority, and/or pro-rata priority systems, and/or any other suitable priority system for matching orders. Traditional matching may prioritize volume, benefiting buyers 8506 (bidders) and sellers 8508 (askers). Price-time-priority may match an earliest bid at a highest price before any similar bids at the same price that entered after, such as via a FIFO system. Pro-rata priority may match equivalently priced bids to a matching ask proportional to an amount of active bids.

In embodiments, the engine 8500 may facilitate order matching for transactions involving a plurality of blockchains and/or distributed ledgers. A smart contract may be stored on a single chain and/or ledger. As such, cross-chain or buy-into/selling-out-of actions may often require interacting with multiple blockchains.

In embodiments, the engine 8500 may facilitate creations and/or management of a parent contract that launches on several blockchains and/or ledgers, thereby allowing for transacting between the blockchains and/or ledgers. Each blockchain and/or ledger may require an exchange ratio, and/or may exist on a stand-alone chain that can host parent contracts. Buying-into/selling-out-of transactions may occur with stablecoins.

In some embodiments, the engine 8500 may facilitate one or more processes by which the order matching system may operate using a time priority. The principle of price/time priority refers to how orders are prioritized for execution. Orders are first ranked according to their price; orders of the same price are then ranked depending on when they were entered. Network based time speed priority allows for leveling playing field, e.g., via clock synchronization across parties.

In some embodiments, the engine 8500 may facilitate one or more processes by which the order matching system may operate using a parity priority. The parity priority rewards those who set the best price, then allocates the remaining shares to other orders that match that price. By sharing the allocation among those who post the best price, rather than based on how quickly they place the order, institutional investors benefit from better fill rates, execution costs, and the ability to share executions at the same price as faster participants.

In embodiments, the engine 8500 may include a or interface with a robotic process automation (RPA) module configured to perform high-frequency, repeatable tasks that would otherwise be performed by a human. The RPA module may operate by consistently applying rules and adherence to control frameworks, thereby reducing processing time of the tasks.

In embodiments, the engine 8500 may include an intelligent agent module configured to create, configure, and manage one or more intelligent agents. The intelligent agents may make decisions and/or perform one or more services based on an environment, user input, and experiences. The intelligent agents can autonomously gather information (e.g., on a regular, programmed schedule or upon being prompted by a user). Examples of tasks that the engine 8500 may perform via one or more intelligent agents include automating interactive and sophisticated processes, performing front office business operations, performing intelligent, contextual, updated client outreach, performing communication via email, text, other messaging platforms, performing negotiation, performing RPA assisted negotiation, provide negotiation terms and alternatives, performing full negotiation based on a gaming/logic engine, performing social media interaction, responding to client comments on social media, “liking” or otherwise interacting with relevant social media posts, performing content reposting and/or generation, improving end-user experience, monitoring and/or shadowing human-human exchanges, perform actions based human-human exchanges, preparing packages, accounts and/or loans for opening, delivering and/or interacting with off-channel content and/or services, automating accounting for transactions, automating execution, providing analytics that create sophisticated and accurate frameworks, automating pricing of cross-market products based on comparable prices for direct services from competitors, execution of contract terms, etc. For example, the engine 8500 may employ an intelligent agent to perform mortgage cross-selling enhanced by IoT data and AI. The intelligent agent may perform enterprise churn prediction and determine preventative negotiated rates to minimize customer loss. By way of another example, in a healthcare environment including regulations, insurance, and/or finance management, the engine 8500 may employ an intelligent agent to assist with determining and analyzing a choice of banks, bank accounts, and bank features, facilitate regulatory handoffs and self-validation. The intelligent agent may assist a service provider with a portal for deposits, withdrawals, and/or compliance reporting. The intelligent agent may merge health insurance claim streams with bank account activity data and user actions. The intelligent agent may facilitate creation and management of a health portal for a health insurance provider. The health portal may contain highly confidential information which may be managed via blockchain and/or distributed ledger. The intelligent agent may assist with bill payment services, such as by handling direct payments and/or automatic payments for approved claims. The intelligent agent may assist with add-on financial and/or investments services, such as HSA spending management. The intelligent agent may be configured to create and/or manage a smart wallet. The smart wallet may be configured to manage one or more actions related to a regulated HAS, such as policy and governance of data presentation, validation without invading privacy, and/or payments for health services.

In embodiments, the engine 8500 may facilitate one or more processes by which the RPA module, coupled with intelligent agents, can automate interactive and sophisticated processes, as well as perform front-office business operations. As such, the RPA module can operate with high-intensity workloads that seamlessly integrate for improved end-user experience. The intelligent agents can work in synergy with other digital and automation technologies, such as IoT (Internet of Things), and analytics, to create sophisticated and accurate frameworks. For example, the engine 8500 may enable mortgage cross-selling enhanced by IoT data and AI via the RPA module and the intelligent agent module. Thereby the engine 8500 may perform enterprise churn prediction and predict preventative negotiated rates to minimize customer loss.

In embodiments, the engine 8500 may be configured to, via one or both of the RPA module and the one or more intelligent agents, dynamically optimize market conditions, such as prices, liquidity, availability, etc. of traded assets and/or currencies (cryptocurrencies, fiat currencies) based on real-time intelligence. For example, on the lending side, cost of acquisition of customers and type of loan and quality of underwriting (e.g., filters to the incoming funnel) can be adjusted based on current market conditions of those in the funnel (e.g., data from the funnel). Moreover, the need to discount the sale of servicing can be tied to the acquisition.

In embodiments, the engine 8500 may be configured to perform gamification of internal burn rate. The engine 8500 may cross-reference internal burn rate with third-party bandwidth, such as bandwidth of a title company, and provide incentives to move a closing to accommodate needs.

In embodiments, the engine 8500 may perform or facilitate adjustment of underlying insurance contracts to ensure beneficiaries of policy are made whole upon default of the asset owner.

In embodiments, the engine 8500 may be configured to create, manage, and/or facilitate transactions for NFT-based titles of real estate. The engine 8500 may facilitate crowdsourcing the confidence in tracing title, and, in embodiments, may build a token based on crowdsourced information, especially where underlying records are gone.

### Market Prediction System

Referring to FIG. 87, the present disclosure relates to a market prediction system platform 8700 that is configured to generate market predictions (e.g., a prediction about a set of markets, a prediction about market share, a prediction about a set of marketplaces, a prediction about a set of assets, a prediction about the pricing of a set of assets, a prediction about a set of transactions, a prediction about a parameter of demand, a prediction about a parameter of supply, a prediction about a set of contracts, a prediction about a set of smart contracts, a prediction about the terms or conditions of a smart contract, a prediction about a party in a market, and many others), referred to herein in the alternative as the “platform,” the “system” or the like, with such terms comprising various alternative embodiments involving various sets of components, modules, systems, sub-systems, processes, services, methods, and other elements described herein and in the documents incorporated herein by reference.

According to embodiments herein, a market or a marketplace may refer to an environment configured to facilitate transactions related to a set of assets. Assets may refer to commodities, physical assets, products, digital assets, services, stocks, bonds, marketplace-traded funds (ETF), mutual funds, currencies, foreign exchange (FX), artwork and other works of authorship, alternative assets, recycled plastics, digital 3D designs, digital gaming assets, virtual goods, real estate, placement rights (such as for advertising), cryptocurrencies, metals and alloys, energy resources, derivatives (such as futures, forwards, options, puts, calls, and swaps), 3D printing capacity, digital twins, storage, intellectual property (e.g., trade secrets, patents, trademarks, designs, know how, privacy rights, publicity rights, and others), instruction sets, hybrid instruments, synthetic instruments, tranches of assets (including similar and mixed-asset tranches), streams of value (such as of interest), certificates of deposit (CDs), and the like, as well as portions of the above (such as divisible and undivided interests), hybrids of the above, and aggregates of the above (including tranches of securities, mutual funds, index funds, and others).

In some embodiments, a marketplace may be a forward marketplace. In embodiments, a forward marketplace may refer to an electronic marketplace that provides a medium for counterparties to negotiate and engage in forward contracts. A forward contract may refer to a customized contract between two parties to buy/sell a negotiated quantity of an asset at a negotiated price on a negotiated date. Examples of assets that may be sold using forward contracts include agricultural commodities (e.g., wheat, corn, oranges, cotton, and/or the like), natural resources (e.g., natural gas, oil, gold, silver, platinum, or the like), financial instruments (e.g., stocks, bonds, currencies, or the like), non-traditional assets and/or other suitable commodities (e.g., fuel, electricity, energy, computational resources (e.g., quantum computational resources), storage capacity, network capacity, network spectrum, advertising, attention resources, cryptocurrencies, defined income streams, data streams (such as sensor data, network data and the like), knowledge structures, and many others.

In embodiments, the market prediction system may be configured to predict a parameter of demand for a set of assets. In embodiments, the parameter of demand may be a transaction parameter, a price, a total contract value, a profit margin value, a timing parameter, and many others.

In embodiments, the platform 8700 includes an API system that facilitates the transfer of data between a set of external systems and the platform 8700. In some embodiments, the platform 8700 includes databases that store data relating to markets, marketplaces, transactions, contracts (e.g., smart contracts), assets, predictions, and the like.

In embodiments, the platform 8700 includes and/or integrates with an intelligence services system (also referred to as “intelligence services”), described throughout this document and by documents referenced herein. In embodiments, the intelligence services system provides a framework for providing intelligence services to the market prediction system platform 8700. In some embodiments, the intelligence services framework may be adapted to be at least partially replicated in the market prediction system platform 8700. In these embodiments, the market prediction system platform 8700 may include some or all of the capabilities of the intelligence services, whereby the intelligence services is adapted for the specific functions performed by the subsystems of the intelligence client. Additionally or alternatively, in some embodiments, the intelligence services may be implemented as a set of microservices, such that the market prediction system platform 8700 may leverage the intelligence services via one or more APIs exposed to the platform 8700. In embodiments, the market prediction system platform 8700 may provide an intelligence request to the intelligence services, whereby the request is to perform a specific intelligence task (e.g., a prediction). In some embodiments, the market prediction system platform 8700 may request non-prediction intelligence tasks, including decisions, recommendations, reports, control instructions, classifications, training actions, NLP requests, digital twin requests, RPA requests, or the like. In response, the intelligence services executes the requested intelligence task and returns a response to the market prediction system platform 8700. Additionally or alternatively, in some embodiments, the intelligence services may be implemented using one or more specialized chips that are configured to provide AI assisted microservices such as image processing, diagnostics, location and orientation, chemical analysis, data processing, and so forth.

In embodiments, the platform 8700 includes and/or integrates with a quantum computing system (also referred to as “quantum services”), described throughout this document and by documents referenced herein. In embodiments, the quantum computing system provides a framework for providing a set of quantum computing services to the market prediction system platform 8700. In some embodiments, the quantum computing system framework may be at least partially replicated in the market prediction system platform 8700. In these embodiments, the market prediction system platform 8700 may include some or all of the capabilities of the quantum computing system, whereby the quantum computing system is adapted for the specific functions performed by the subsystems of the quantum computing client. Additionally, or alternatively, in some embodiments, the quantum computing system may be implemented as a set of microservices, such that the market prediction system platform 8700 may leverage the quantum computing system via one or more APIs exposed to the platform 8700. In these embodiments, the quantum computing system may be configured to perform various types of quantum computing services that may be adapted for different quantum computing clients. In either of these configurations, a quantum computing client may provide a request to the quantum computing system, whereby the request is to perform a specific quantum computing task (e.g., a quantum prediction). In response, the quantum computing system executes the requested task and returns a response to the quantum computing client.

In embodiments, a market prediction system platform 8700 is provided having a crowdsourcing system for obtaining information that may be relevant to generating market predictions (e.g., a prediction about a set of markets, a prediction about market share, a prediction about a set of marketplaces, a prediction about a set of assets, a prediction about the pricing of a set of assets, a prediction about a set of transactions, a prediction about a parameter of demand, a prediction about a parameter of supply, a prediction about a set of contracts, a prediction about a set of smart contracts, a prediction about the terms or conditions of a smart contract, a prediction about a party in a market, and many others), including information related to product availability, product pricing, delivery timing, need for refill, need for replacement, manufacturer recall, need for upgrade, need for maintenance, need for update, need for repair, need for consumable, taste, preference, inferred need, inferred want, group demand, individual demand, family demand, business demand, need for workflow, need for process, need for procedure, need for treatment, need for improvement, need for diagnosis, compatibility to system, compatibility to product, compatibility to style, compatibility to brand, demographic, psychographic, geolocation, indoor location, destination, route, home location, visit location, workplace location, business location, personality, mood, emotion, customer behavior, business type, business activity, personal activity, wealth, income, purchasing history, shopping history, search history, engagement history, clickstream history, website history, online navigation history, group behavior, family behavior, family membership, customer identity, group identity, business identity, customer profile, business profile, group profile, family profile, declared interest, inferred interest factors, component availability, material availability, component location, material location, component pricing, material pricing, taxation, tariff, impost, duty, import regulation, export regulation, border control, trade regulation, customs, navigation, traffic, congestion, vehicle capacity, ship capacity, container capacity, package capacity, vehicle availability, ship availability, container availability, package availability, vehicle location, ship location, container location, port location, port availability, port capacity, storage availability, storage capacity, warehouse availability, warehouse capacity, fulfillment center location, fulfillment center availability, fulfillment center capacity, asset owner identity, system compatibility, worker availability, worker competency, worker location, goods pricing, fuel pricing, energy pricing, route availability, route distance, route cost, route safety, and many others.

A blockchain, such as optionally embodying a distributed ledger, may be configured with a set of smart contracts to administer a reward for the submission of information. In embodiments, a blockchain, such as optionally distributed in a distributed ledger, may be used to configure a request for information along with terms and conditions related to the information, such as a reward for submission of the information, a set of terms and conditions related to the use of the information), and various parameters, such as timing parameters, the nature of the information required (such as independently validated information like video footage, photographs, witnessed statements, or the like), and other parameters.

In embodiments, the market prediction system collects data from a set of Internet of Things systems that collect information about a set of entities in a set of environments. In embodiments, the Internet of Things systems may include smart home Internet of Things devices, workplace Internet of Things devices, Internet of Things devices to monitor a set of consumer goods stores, and many others, including any of the Internet of Things devices described throughout this document and the documents incorporated by reference herein. In embodiments, the Internet of Things systems may be configured to collect information (e.g., behavioral information) about a set of entities in a set of environments.

In embodiments, the entities may include products, suppliers, producers, manufacturers, retailers, businesses, owners, operators, operating facilities, customers, consumers, workers, mobile devices, wearable devices, distributors, resellers, supply chain infrastructure facilities, supply chain processes, logistics processes, reverse logistics processes, demand prediction processes, demand management processes, demand aggregation processes, machines, ships, barges, warehouses, maritime ports, airports, airways, waterways, roadways, railways, bridges, tunnels, online retailers, ecommerce sites, demand factors, supply factors, delivery systems, floating assets, points of origin, points of destination, points of storage, points of use, networks, information technology systems, software platforms, distribution centers, fulfillment centers, containers, container handling facilities, customs, export control, border control, drones, robots, autonomous vehicles, hauling facilities, drones/robots/AVs, waterways, port infrastructure facilities, and many others.

In embodiments, the environments may include the home of a consumer, retail facilities, manufacturing facilities, supply chain facilities, ship containers, ship, boat, barge, maritime port, crane, container, container handling facilities, shipyard, maritime dock, warehouse, distribution facilities, fulfillment facilities, fueling facilities, refueling facilities, nuclear refueling facilities, waste removal facilities, food supply facilities, beverage supply facilities, drone facilities, robot facilities, autonomous vehicle, aircraft, automotive, truck, train, lift, forklift, hauling facilities, conveyor, loading dock, waterway, bridge, tunnel, airport, depot, vehicle station, train station, weigh station, inspection station or point, roadway, railway, highway, customs house, border control facilities, and many others.

In embodiments, the market prediction system platform 8700 leverages the intelligence services system to generate a prediction (e.g., a prediction about a set of markets, a prediction about market share, a prediction about a set of marketplaces, a prediction about a set of assets, a prediction about the pricing of a set of assets, a prediction about a set of transactions, a prediction about a parameter of demand, a prediction about a parameter of supply, a prediction about a set of contracts, a prediction about a set of smart contracts, a prediction about the terms or conditions of a smart contract, a prediction about a party in a market, and many others). In these embodiments, the predictions may be based on many different sources of data, including crowdsourced data, data collected from IT systems, simulation data (e.g., such as from simulations performed by digital twins), external data (e.g., social media data, news data, and the like), and many others. In embodiments, the market prediction system platform 8700 leverages the intelligence services system for non-prediction intelligence tasks.

In examples, a set of machine-learned models may be used to predict the price of an asset at some future point in time. In embodiments, a “set” of machine-learned models may include a set with one member. In embodiments, a “set” of machine-learned models may include a set with multiple members. In embodiments, a “set” of machine-learned models may include hybrids of different types of models (e.g., hybrids of RNN and CNN). In this example, the intelligent services may receive a request to generate a prediction and asset data, historical pricing data, discussion board data, and news data from the market prediction system platform 8700 and may generate a set of feature vectors based on the received data. The intelligent services system may input the feature vector into the set of machine-learned models trained specifically for the asset (e.g., using a combination of simulation data and real-world data) to generate a prediction of the price of the asset at the future point in time and return the prediction to the market prediction system platform 8700. In embodiments, the feature vector may include a set of predictions, such as ones made by human experts, by other systems, and/or by other models. Such artificial intelligence systems used for prediction (in this example and other examples described throughout this disclosure) may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to predict a parameter of demand for an asset in a forward marketplace using crowdsourced data. In this example, the intelligent services may receive asset data, historical pricing data, and data collected by the crowdsourcing system from the market prediction system platform 8700 and may generate a set of feature vectors based on the received data. The intelligent services system may input the feature vector into the set of machine-learned models trained specifically for the asset (e.g., using a combination of simulation data and real-world data) to predict a parameter of demand related to that asset and return that prediction to the market prediction system platform 8700. In embodiments, the feature vector may include a set of predictions, such as ones made by human experts, by other systems, and/or by other models. Such artificial intelligence systems used for prediction (in this example and other examples described throughout this disclosure) may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to predict a parameter of demand for an asset in a forward marketplace using data collected by a set of Internet of Things systems collecting information from a set of entities in a set of environments. In this example, the intelligent services may receive asset data, news data, and data collected by the set of Internet of Things systems from the market prediction system platform 8700 and may generate a set of feature vectors based on the received data. The intelligent services system may input the feature vector into the set of machine-learned models trained specifically for the asset (e.g., using a combination of simulation data and real-world data) to predict a parameter of demand related to that asset and return the prediction to the market prediction system platform 8700. In embodiments, the feature vector may include a set of predictions, such as ones made by human experts, by other systems, and/or by other models. Such artificial intelligence systems used for prediction (in this example and other examples described throughout this disclosure) may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In examples, a set of machine-learned models may be used to predict the terms and/or conditions of a smart contract for a transaction related to a set of assets. In this example, the intelligent services may receive public smart contract data, data collected by the crowdsourcing system, and data collected from a set of Internet of Things systems about a set of entities in a set of environments from the market prediction system platform 8700 and may generate a set of feature vectors based on the received data. The intelligent services system may input the feature vector into the set of machine-learned models trained specifically for the smart contracts related to that set of assets (e.g., using a combination of simulation data and real-world data) to predict the terms and/or conditions of a smart contract related to a transaction for that set of assets and return the prediction to the market prediction system platform 8700. In embodiments, the feature vector may include a set of predictions, such as ones made by human experts, by other systems, and/or by other models. Such artificial intelligence systems used for prediction (in this example and other examples described throughout this disclosure) may include a recurrent neural network (including a gated recurrent neural network), a convolutional neural network, a combination of a recurrent neural network and a convolutional neural network, or other types of neural network or combination or hybrid of types of neural network described herein or in the documents incorporated by reference herein.

In embodiments, the market prediction system platform 8700 leverages the quantum computing system to generate a quantum prediction (e.g., a prediction about a set of markets, a prediction about market share, a prediction about a set of marketplaces, a prediction about a set of assets, a prediction about the pricing of a set of assets, a prediction about a set of transactions, a prediction about a parameter of demand, a prediction about a parameter of supply, a prediction about a set of contracts, a prediction about a set of smart contracts, a prediction about the terms or conditions of a smart contract, a prediction about a party in a market, and many others). In these embodiments, the predictions may be based on many different sources of data, including crowdsourced data, data collected from IoT systems, external data (e.g., social media data, news data, and the like), and many others. In embodiments, the market prediction system platform 8700 leverages the quantum computing system for non-prediction quantum computing tasks. In either of these configurations, a quantum computing client may provide a request to the quantum computing system, whereby the request is to perform a specific quantum computing task. In response, the quantum computing system executes the requested task and returns a response to the quantum computing client.

### Quantum Computing Systems

FIG. 88 illustrates an example quantum computing system 8800 according to some embodiments of the present disclosure. In embodiments, the quantum computing system 8800 provides a framework for providing a set of quantum computing services to one or more quantum computing clients. In some embodiments, the quantum computing system 8800 framework may be at least partially replicated in respective quantum computing clients. In these embodiments, an individual client may include some or all of the capabilities of the quantum computing system 8800, whereby the quantum computing system 8800 is adapted for the specific functions performed by the subsystems of the quantum computing client. Additionally, or alternatively, in some embodiments, the quantum computing system 8800 may be implemented as a set of microservices, such that different quantum computing clients may leverage the quantum computing system 8800 via one or more APIs exposed to the quantum computing clients. In these embodiments, the quantum computing system 8800 may be configured to perform various types of quantum computing services that may be adapted for different quantum computing clients. In either of these configurations, a quantum computing client may provide a request to the quantum computing system 8800, whereby the request is to perform a specific task (e.g., an optimization). In response, the quantum computing system 8800 executes the requested task and returns a response to the quantum computing client.

Referring to FIG. 88, in some embodiments, the quantum computing system 8800 may include a quantum adapted services library 8802, a quantum general services library 8804, a quantum data services library 8806, a quantum computing engine library 8808, a quantum computing configuration service 8810, a quantum computing execution system 8812, and quantum computing API interface 8814.

In embodiments, the quantum computing engine library 8808 includes quantum computing engine configurations 8816 and quantum computing process modules 8818 based on various supported quantum models. In embodiments, the quantum computing system 8800 may support many different quantum models, including, but not limited to, the quantum circuit model, quantum Turing machine, adiabatic quantum computer, spintronic computing system (such as using spin-orbit coupling to generate spin-polarized electronic states in non-magnetic solids, such as ones using diamond materials), one-way quantum computer, quantum annealing, and various quantum cellular automata. Under the quantum circuit model, quantum circuits may be based on the quantum bit, or “qubit”, which is somewhat analogous to the bit in classical computation. Qubits may be in a 1 or 0 quantum state or they may be in a superposition of the 1 and 0 states. However, when qubits have measured the result of a measurement, qubits will always be in is always either a 1 or 0 quantum state. The probabilities related to these two outcomes depend on the quantum state that the qubits were in immediately before the measurement. Computation is performed by manipulating qubits with quantum logic gates, which are somewhat analogous to classical logic gates.

In embodiments, the quantum computing system 8800 may be physically implemented using an analog approach or a digital approach. Analog approaches may include, but are not limited to, quantum simulation, quantum annealing, and adiabatic quantum computation. In embodiments, digital quantum computers use quantum logic gates for computation. Both analog and digital approaches may use quantum bits, or qubits.

In embodiments, the quantum computing system 8800 includes a quantum annealing module 8820 wherein the quantum annealing module may be configured to find the global minimum or maximum of a given objective function over a given set of candidate solutions (e.g., candidate states) using quantum fluctuations. As used herein, quantum annealing may refer to a meta-procedure for finding a procedure that identifies an absolute minimum or maximum, such as a size, length, cost, time, distance or other measure, from within a possibly very large, but finite, set of possible solutions using quantum fluctuation-based computation instead of classical computation. The quantum annealing module 8820 may be leveraged for problems where the search space is discrete (e.g., combinatorial optimization problems) with many local minima, such as finding the ground state of a spin glass or the traveling salesman problem.

In embodiments, the quantum annealing module 8820 starts from a quantum-mechanical superposition of all possible states (candidate states) with equal weights. The quantum annealing module 8820 may then evolve, such as following the time-dependent Schrödinger equation, a natural quantum-mechanical evolution of systems (e.g., physical systems, logical systems, or the like). In embodiments, the amplitudes of all candidate states change, realizing quantum parallelism according to the time-dependent strength of the transverse field, which causes quantum tunneling between states. If the rate of change of the transverse field is slow enough, the quantum annealing module 8820 may stay close to the ground state of the instantaneous Hamiltonian. If the rate of change of the transverse field is accelerated, the quantum annealing module 8820 may leave the ground state temporarily but produce a higher likelihood of concluding in the ground state of the final problem energy state or Hamiltonian.

In embodiments, the quantum computing system 8800 may include arbitrarily large numbers of qubits and may transport ions to spatially distinct locations in an array of ion traps, building large, entangled states via photonically connected networks of remotely entangled ion chains.

In some implementations, the quantum computing system 8800 includes a trapped ion computer module 8822, which may be a quantum computer that applies trapped ions to solve complex problems. Trapped ion computer module 8822 may have low quantum decoherence and may be able to construct large solution states. Ions, or charged atomic particles, may be confined and suspended in free space using electromagnetic fields. Qubits are stored in stable electronic states of each ion, and quantum information may be transferred through the collective quantized motion of the ions in a shared trap (interacting through the Coulomb force). Lasers may be applied to induce coupling between the qubit states (for single-qubit operations) or coupling between the internal qubit states and the external motional states (for entanglement between qubits).

In some embodiments of the invention, a traditional computer, including a processor, memory, and a graphical user interface (GUI), may be used for designing, compiling, and providing output from the execution and the quantum computing system 8800 may be used for executing the machine language instructions. In some embodiments of the invention, the quantum computing system 8800 may be simulated by a computer program executed by the traditional computer. In such embodiments, a superposition of states of the quantum computing system 8800 can be prepared based on input from the initial conditions. Since the initialization operation available in a quantum computer can only initialize a qubit to either the |0> or |1> state, initialization to a superposition of states is physically unrealistic. For simulation purposes, however, it may be useful to bypass the initialization process and initialize the quantum computing service QNTM1114 directly.

In some embodiments, the quantum computing system 8800 provides various quantum data services, including quantum input filtering, quantum output filtering, quantum application filtering, and a quantum database engine.

In embodiments, the quantum computing system 8800 may include a quantum input filtering service 8824. In embodiments, quantum input filtering service 8824 may be configured to select whether to run a model on the quantum computing system 8800 or to run the model on a classic computing system. In some embodiments, quantum input filtering service 8824 may filter data for later modeling on a classic computer. In embodiments, the quantum computing system 8800 may provide input to traditional compute platforms while filtering out unnecessary information from flowing into distributed systems. In some embodiments, the platform 8800 may trust through filtered specified experiences for intelligent agents.

In embodiments, a system in the system of systems may include a model or system for automatically determining, based on a set of inputs, whether to deploy quantum computational or quantum algorithmic resources to an activity, whether to deploy traditional computational resources and algorithms, or whether to apply a hybrid or combination of them. In embodiments, inputs to a model or automation system may include demand information, supply information, financial data, energy cost information, capital costs for computational resources, development costs (such as for algorithms), energy costs, operational costs (including labor and other costs), performance information on available resources (quantum and traditional), and any of the many other data sets that may be used to simulate (such as using any of a wide variety of simulation techniques described herein and/or in the documents incorporated herein by reference) and/or predict the difference in outcome between a quantum-optimized result and a non-quantum-optimized result. A machine learned model (including in a DPANN system) may be trained, such as by deep learning on outcomes or by a data set from human expert decisions, to determine what set of resources to deploy given the input data for a given request. The model may itself be deployed on quantum computational resources and/or may use quantum algorithms, such as quantum annealing, to determine whether, where and when to use quantum systems, conventional systems, and/or hybrids or combinations.

In some embodiments of the invention, the quantum computing system 8800 may include a quantum output filtering service 8826. In embodiments, the quantum output filtering service 8826 may be configured to select a solution from solutions of multiple neural networks. For example, multiple neural networks may be configured to generate solutions to a specific problem and the quantum output filtering service 8826 may select the best solution from the set of solutions.

In some embodiments, the quantum computing system 8800 connects and directs a neural network development or selection process. In this embodiment, the quantum computing system 8800 may directly program the weights of a neural network such that the neural network gives the desired outputs. This quantum-programmed neural network may then operate without the oversight of the quantum computing system 8800 but will still be operating within the expected parameters of the desired computational engine.

In embodiments, the quantum computing system 8800 includes a quantum database engine 8828. In embodiments, the quantum database engine 8828 is configured with in-database quantum algorithm execution. In embodiments, a quantum query language may be employed to query the quantum database engine 8828. In some embodiments, the quantum database engine may have an embedded policy engine 8830 for prioritization and/or allocation of quantum workflows, including prioritization of query workloads, such as based on overall priority as well as the comparative advantage of using quantum computing resources versus others. In embodiments, quantum database engine 8828 may assist with the recognition of entities by establishing a single identity for that is valid across interactions and touchpoints. The quantum database engine 8828 may be configured to perform optimization of data matching and intelligent traditional compute optimization to match individual data elements. The quantum computing system 8800 may include a quantum data obfuscation system for obfuscating data.

The quantum computing system 8800 may include, but is not limited to, analog quantum computers, digital computers, and/or error-corrected quantum computers. Analog quantum computers may directly manipulate the interactions between qubits without breaking these actions into primitive gate operations. In embodiments, quantum computers that may run analog machines include, but are not limited to, quantum annealers, adiabatic quantum computers, and direct quantum simulators. The digital computers may operate by carrying out an algorithm of interest using primitive gate operations on physical qubits. Error-corrected quantum computers may refer to a version of gate-based quantum computers made more robust through the deployment of quantum error correction (QEC), which enables noisy physical qubits to emulate stable logical qubits so that the computer behaves reliably for any computation. Further, quantum information products may include, but are not limited to, computing power, quantum predictions, and quantum inventions.

In some embodiments, the quantum computing system 8800 is configured as an engine that may be used to optimize traditional computers, integrate data from multiple sources into a decision-making process, and the like. The data integration process may involve real-time capture and management of interaction data by a wide range of tracking capabilities. In embodiments, the quantum computing system 8800 may be configured to accept cookies, email addresses and other contact data, social media feeds, news feeds, event and transaction log data (including transaction events, network events, computational events, and many others), event streams, results of web crawling, distributed ledger information (including blockchain updates and state information), results from distributed or federated queries of data sources, streams of data from chat rooms and discussion forums, and many others.

In embodiments, the quantum computing system 8800 includes a quantum register having a plurality of qubits. Further, the quantum computing system 8800 may include a quantum control system for implementing the fundamental operations on each of the qubits in the quantum register and a control processor for coordinating the operations required.

In embodiments, the quantum computing system 8800 is configured to optimize the pricing of a set of goods or services. In embodiments, the quantum computing system 8800 may utilize quantum annealing to provide optimized pricing. In embodiments, the quantum computing system 8800 may use q-bit based computational methods to optimize pricing.

In embodiments, the quantum computing system 8800 is configured to automatically discover smart contract configuration opportunities. Automated discovery of smart contract configuration opportunities may be based on published APIs to marketplaces and machine learning (e.g., by robotic process automation (RPA) of stakeholder, asset, and transaction types.

In embodiments, quantum-established or other blockchain-enabled smart contracts enable frequent transactions occurring among a network of parties, and manual or duplicative tasks are performed by counterparties for each transaction. The quantum-established or other blockchain acts as a shared database to provide a secure, single source of truth, and smart contracts automate approvals, calculations, and other transacting activities that are prone to lag and error. Smart contracts may use software code to automate tasks, and in some embodiments, this software code may include quantum code that enables extremely sophisticated optimized results.

In embodiments, the quantum computing system 8800 or other system in the system of systems may include a quantum-enabled or other risk identification module that is configured to perform risk identification and/or mitigation. The steps that may be taken by the risk identification module may include, but are not limited to, risk identification, impact assessment, and the like. In some embodiments, the risk identification module determines a risk type from a set of risk types. In embodiments, risks may include, but are not limited to, preventable, strategic, and external risks. Preventable risks may refer to risks that come from within and that can usually be managed on a rule-based level, such as employing operational procedures monitoring and employee and manager guidance and instruction. Strategy risks may refer to those risks that are taken on voluntarily to achieve greater rewards. External risks may refer to those risks that originate outside and are not in the businesses' control (such as natural disasters). External risks are not preventable or desirable. In embodiments, the risk identification module can determine a predicted cost for many categories of risk. The risk identification module may perform a calculation of current and potential impact on an overall risk profile. In embodiments, the risk identification module may determine the probability and significance of certain events. Additionally, or alternatively, the risk identification module may be configured to anticipate events.

In embodiments, the quantum computing system 8800 or other system of the platform 8800 is configured for graph clustering analysis for anomaly and fraud detection.

In some embodiments, the quantum computing system 8800 includes a quantum prediction module, which is configured to generate predictions. Furthermore, the quantum prediction module may construct classical prediction engines to further generate predictions, reducing the need for ongoing quantum calculation costs, which, can be substantial compared to traditional computers.

In embodiments, the quantum computing system 8800 may include a quantum principal component analysis (QPCA) algorithm that may process input vector data if the covariance matrix of the data is efficiently obtainable as a density matrix, under specific assumptions about the vectors given in the quantum mechanical form. It may be assumed that the user has quantum access to the training vector data in a quantum memory. Further, it may be assumed that each training vector is stored in the quantum memory in terms of its difference from the class means. These QPCA algorithms can then be applied to provide for dimension reduction using the calculational benefits of a quantum method.

In embodiments, the quantum computing system 8800 is configured for graph clustering analysis for certified randomness for proof-of-stake blockchains. Quantum cryptographic schemes may make use of quantum mechanics in their designs, which enables such schemes to rely on presumably unbreakable laws of physics for their security. The quantum cryptography schemes may be information-theoretically secure such that their security is not based on any non-fundamental assumptions. In the design of blockchain systems, information-theoretic security is not proven. Rather, classical blockchain technology typically relies on security arguments that make assumptions about the limitations of attackers' resources.

In embodiments, the quantum computing system 8800 is configured for detecting adversarial systems, such as adversarial neural networks, including adversarial convolutional neural networks. For example, the quantum computing system 8800 or other system of the platform 8800 may be configured to detect fake trading patterns.

In embodiments, the quantum computing system 8800 includes a quantum continual learning (QCL) system 8832, wherein the QCL system 8832 learns continuously and adaptively about the external world, enabling the autonomous incremental development of complex skills and knowledge by updating a quantum model to account for different tasks and data distributions. The QCL system 8832 operates on a realistic time scale where data and/or tasks become available only during operation. Previous quantum states can be superimposed into the quantum engine to provide the capacity for QCL. Because the QCL system 8832 is not constrained to a finite number of variables that can be processed deterministically, it can continuously adapt to future states, producing a dynamic continual learning capability. The QCL system 8832 may have applications where data distributions stay relatively static, but where data is continuously being received. For example, the QCL system 8832 may be used in quantum recommendation applications or quantum anomaly detection systems where data is continuously being received and where the quantum model is continuously refined to provide for various outcomes, predictions, and the like. QCL enables asynchronous alternate training of tasks and only updates the quantum model on the real-time data available from one or more streaming sources at a particular moment.

In embodiments, the QCL system 8832 operates in a complex environment in which the target data keeps changing based on a hidden variable that is not controlled. In embodiments, the QCL system 8832 can scale in terms of intelligence while processing increasing amounts of data and while maintaining a realistic number of quantum states. The QCL system 8832 applies quantum methods to drastically reduce the requirement for storage of historic data while allowing the execution of continuous computations to provide for detail-driven optimal results. In embodiments, a QCL system 8832 is configured for unsupervised streaming perception data since it continually updates the quantum model with new available data.

In embodiments, QCL system 8832 enables multi-modal-multi-task quantum learning. The QCL system 8832 is not constrained to a single stream of perception data but allows for many streams of perception data from different sensors and input modalities. In embodiments, the QCL system 8832 can solve multiple tasks by duplicating the quantum state and executing computations on the duplicate quantum environment. A key advantage to QCL is that the quantum model does not need to be retrained on historic data, as the superposition state holds information relating to all prior inputs. Multi-modal and multi-task quantum learning enhance quantum optimization since it endows quantum machines with reasoning skills through the application of vast amounts of state information.

In embodiments, the quantum computing system 8800 supports quantum superposition, or the ability of a set of states to be overlaid into a single quantum environment.

In embodiments, the quantum computing system 8800 supports quantum teleportation. For example, information may be passed between photons on chipsets even if the photons are not physically linked.

In embodiments, the quantum computing system 8800 may include a quantum transfer pricing system. Quantum transfer pricing allows for the establishment of prices for the goods and/or services exchanged between subsidiaries, affiliates, or commonly controlled companies that are part of a larger enterprise and may be used to provide tax savings for corporations. In embodiments, solving a transfer pricing problem involves testing the elasticities of each system in the system of systems with a set of tests. In these embodiments, the testing may be done in periodic batches and then may be iterated. As described herein, transfer pricing may refer to the price that one division in a company charges another division in that company for goods and services.

In embodiments, the quantum transfer pricing system consolidates all financial data related to transfer pricing on an ongoing basis throughout the year for all entities of an organization wherein the consolidation involves applying quantum entanglement to overlay data into a single quantum state. In embodiments, the financial data may include profit data, loss data, data from intercompany invoices (potentially including quantities and prices), and the like.

In embodiments, the quantum transfer pricing system may interface with a reporting system that reports segmented profit and loss, transaction matrices, tax optimization results, and the like based on superposition data. In embodiments, the quantum transfer pricing system automatically generates forecast calculations and assesses the expected local profits for any set of quantum states.

In embodiments, the quantum transfer pricing system may integrate with a simulation system for performing simulations. Suggested optimal values for new product prices can be discussed cross-border via integrated quantum workflows and quantum teleportation communicated states.

In embodiments, quantum transfer pricing may be used to proactively control the distribution of profits within a multi-national enterprise (MNE), for example, during the course of a calendar year, enabling the entities to achieve arms-length profit ranges for each type of transaction.

In embodiments, the QCL system 8832 may use a number of methods to calculate quantum transfer pricing, including the quantum comparable uncontrolled price (QCUP) method, the quantum cost plus percent method (QCPM), the quantum resale price method (QRPM), the quantum transaction net margin method (QTNM), and the quantum profit-split method.

The QCUP method may apply quantum calculations to find comparable transactions made between related and unrelated organizations, potentially through the sharing of quantum superposition data. By comparing the price of goods and/or services in an intercompany transaction with the price used by independent parties through the application of a quantum comparison engine, a benchmark price may be determined.

The QCPM method may compare the gross profit to the cost of sales, thus measuring the cost-plus mark-up (the actual profit earned from the products). Once this mark-up is determined, it should be equal to what a third party would make for a comparable transaction in a comparable context with similar external market conditions. In embodiments, the quantum engine may simulate the external market conditions.

The QRPM method looks at groups of transactions rather than individual transactions and is based on the gross margin or difference between the price at which a product is purchased and the price at which it is sold to a third party. In embodiments, the quantum engine may be applied to calculate the price differences and to record the transactions in the superposition system.

The QTNM method is based on the net profit of a controlled transaction rather than comparable external market pricing. The calculation of the net profit is accomplished through a quantum engine that can consider a wide variety of factors and solve optimally for the product price. The net profit may then be compared with the net profit of independent enterprises, potentially using quantum teleportation.

The quantum profit-split method may be used when two related companies work on the same business venture, but separately. In these applications, the quantum transfer pricing is based on profit. The quantum profit-split method applies quantum calculations to determine how the profit associated with a particular transaction would have been divided between the independent parties involved.

In embodiments, the quantum computing system 8800 may leverage one or artificial networks to fulfill the request of a quantum computing client. For example, the quantum computing system 8800 may leverage a set of artificial neural networks to identify patterns in images (e.g., using image data from a liquid lens system), perform binary matrix factorization, perform topical content targeting, perform similarity-based clustering, perform collaborative filtering, perform opportunity mining, or the like.

In embodiments, the system of systems may include a hybrid computing allocation system for prioritization and allocation of quantum computing resources and traditional computing resources. In embodiments, the prioritization and allocation of quantum computing resources and traditional computing resources may be measure-based (e.g., measuring the extent of the advantage of the quantum resource relative to other available resources), cost-based, optimality-based, speed-based, impact-based, or the like. In some embodiments the hybrid computing allocation system is configured to perform time-division multiplexing between the quantum computing system 8800 and a traditional computing system. In embodiments, the hybrid computing allocation system may automatically track and report on the allocation of computational resources, the availability of computational resources, the cost of computational resources, and the like.

In embodiments, the quantum computing system 8800 may be leveraged for queue optimization for utilization of quantum computing resources, including context-based queue optimizations.

In embodiments, the quantum computing system 8800 may support quantum-computation-aware location-based data caching.

In embodiments, the quantum computing system 8800 may be leveraged for optimization of various system resources in the system of systems, including the optimization of quantum computing resources, traditional computing resources, energy resources, human resources, robotic fleet resources, smart container fleet resources, I/O bandwidth, storage resources, network bandwidth, attention resources, or the like.

The quantum computing system 8800 may be implemented where a complete range of capabilities are available to or as part of any configured service. Configured quantum computing services may be configured with subsets of these capabilities to perform specific predefined function, produce newly defined functions, or various combinations of both.

FIG. 89 illustrates quantum computing service request handling according to some embodiments of the present disclosure. A directed quantum computing request 8902 may come from one or more quantum-aware devices or stack of devices, where the request is for known application configured with specific quantum instance(s), quantum computing engine(s), or other quantum computing resources, and where data associated with the request may be preprocessed or otherwise optimized for use with quantum computing.

A general quantum computing request 8904 may come from any system in the system of systems or configured service, where the requestor has determined that quantum computing resources may provide additional value or other improved outcomes. Improved outcomes may also be suggested by the quantum computing service in association with some form of monitoring and analysis. For a general quantum computing request 8904, input data may not be structured or formatted as necessary for quantum computing.

In embodiments, external data requests 8906 may include any available data that may be necessary for training new quantum instances. The sources of such requests could be public data, sensors, ERP systems, and many others.

Incoming operating requests and associated data may be analyzed using a standardized approach that identifies one or more possible sets of known quantum instances, quantum computing engines, or other quantum computing resources that may be applied to perform the requested operation(s). Potential existing sets may be identified in the quantum set library 8908.

In embodiments, the quantum computing system 8800 includes a quantum computing configuration service 8810. The quantum computing configuration service may work alone or with the intelligence service 8834 to select a best available configuration using a resource and priority analysis that also includes the priority of the requestor. The quantum computing configuration service may provide a solution (YES) or determine that a new configuration is required (NO).

In one example, the requested set of quantum computing services may not exist in the quantum set library 8908. In this example, one or more new quantum instances must be developed (trained) with the intelligence service 8834 using available data. In embodiments, alternate configurations may be developed with assistance from the intelligence service 8834 to identify alternate ways to provide all or some of the requested quantum computing services until appropriate resources become available. For example, a quantum/traditional hybrid model may be possible that provides the requested service, but at a slower rate.

In embodiments, alternate configurations may be developed with assistance from the intelligence service 8834 to identify alternate and possibly temporary ways to provide all or some of the requested quantum computing services. For example, a hybrid quantum/traditional model may be possible that provides the requested service, but at a slower rate. This may also include a feedback learning loop to adjust services in real time or to improved stored library elements.

When a quantum computing configuration has been identified and available, it is allocated and programmed for execution and delivery of one or more quantum states (solutions).

### Trust Networks

Although cryptocurrencies have experienced growth, the mainstream utility of cryptocurrencies as a medium of exchange may be more limited due to lack of payer protections. For example, cryptocurrency funds sent to a fraudulent party may not be readily recovered. A trust network 9000 of the present disclosure generates consensus trust scores for cryptocurrency transactors. The consensus trust scores can offer cryptocurrency transactors a safeguard against fraud while preserving user anonymity and autonomy. The consensus trust scores may provide a baseline level of trust upon which other security layers can be built, including cryptocurrency payment insurance, protection, and restitution.

A trust network 9000 generates consensus trust scores for cryptocurrency transactors. For example, for a cryptocurrency based on blockchain technology, the trust network 9000 can generate consensus trust scores for different blockchain addresses that interact on the blockchain. The trust network 9000 may determine the consensus trust scores based on data retrieved from various data sources (e.g., fraud/custody data) along with blockchain data upon which the cryptocurrency is based. A trust score (e.g., a consensus trust score) may be a number (e.g., a decimal or integer) that indicates a likelihood that the blockchain address is involved in fraudulent activity. Put another way, a trust score can represent the propensity of a blockchain address to be involved with fraudulent activity.

A cryptocurrency transactor can request consensus trust scores from the trust network 9000 before engaging in a cryptocurrency blockchain transaction in which funds (e.g., cryptocurrency blockchain tokens) are transacted on the blockchain. In general, a cryptocurrency transactor can use a consensus trust score to determine whether the blockchain address with which they are transacting is trustworthy. For example, a transactor that intends to send funds to a receiving party may request a consensus trust score for the receiving party. In this example, the transactor can use the consensus trust score for the intended receiver in order to evaluate the likelihood that the intended receiver is a fraudulent party.

Transactors can use consensus trust scores to take a variety of actions. For example, transactors may use consensus trust scores to determine whether to proceed with or cancel a blockchain transaction. As another example, transactors (e.g., digital exchanges) can use consensus trust scores to determine whether to insure a transaction. As another example, organizations can use consensus trust scores to decide whether to accept funds from a blockchain address. As such, the consensus trust scores described herein can help protect transactors from falling victim to fraud or from receiving fraudulent funds. Note that the consensus trust scores inform the transactors of the degree to which any cryptocurrency address may be trusted without requiring the transactor to know the identity of the party behind the address. As such, the consensus trust scores may preserve transactor anonymity.

FIG. 90 illustrates an example trust network 9000 in communication with cryptocurrency transactor computing devices 9002, 9004, 9006 (hereinafter “transactor computing devices”) via a communication network 9008. The network 9008 may include various types of computer networks, such as a local area network (LAN), wide area network (WAN), and/or the Internet. The trust network 9000 may include a plurality of trust nodes 9000-1, 9000-2, . . . , 9000-N (referred to herein as “nodes”). Each of the nodes 9000 may include one or more node computing devices (e.g., one or more server computing devices) that implement a variety of protocols described herein.

The nodes 9000 may acquire data associated with cryptocurrency blockchain addresses and determine a variety of trust scores based on the acquired data. A trust score determined locally at a node based on the acquired data may be referred to as a “local node trust score” or a “local trust score.” The nodes 9000 may be configured to communicate their local trust scores among one another such that each node may have knowledge of local trust scores associated with other nodes. After a node acquires a plurality of local trust scores, the node may determine a candidate consensus trust score (hereinafter “candidate trust score”) based on the plurality of local trust scores. One or more nodes may determine a consensus trust score based on the plurality of candidate trust scores. The consensus trust score may indicate a consensus value for a local trust score among a plurality of nodes. The consensus trust score for a cryptocurrency address can be written to a distributed consensus ledger and later retrieved from the trust network 9000 (e.g., in response to a trust request).

The trust scores described herein (e.g., local, candidate, or consensus) can be calculated/provided in a variety of formats. In some implementations, a trust score may be an integer value with a minimum and maximum value. For example, a trust score may range from 1-7, where a trust score of ‘1’ indicates that the blockchain address is likely fraudulent. In this example, a trust score of ‘7’ may indicate that the blockchain address is not likely fraudulent (i.e., very trustworthy). In some implementations, a trust score may be a decimal value. For example, the trust score may be a decimal value that indicates a likelihood of fraud (e.g., a percentage value from 0-100%). In some implementations, a trust score may range from a maximum negative value to a maximum positive value (e.g., −1.00 to 1.00), where a larger negative value indicates that the address is more likely fraudulent. In this example, a larger positive value may indicate that the address is more likely trustworthy. The customer may select the trust score format they prefer.

The distributed trust network 9000 described herein distributes the trust score computational workload across a plurality of nodes to produce a resilient network that is resistant to failure/outage and attack. In some implementations, the trust network 9000 may include a built-in transactional autonomy moderated by a token (e.g., UTOKEN) that allows the trust network 9000 to distribute the computational workload. Additionally, distributing trust calculations throughout the network may provide a resistance to fraud/conspiracy intended to corrupt the network.

The transactor computing devices 9002, 9004, 9006 include computing devices that can interact with the trust network 9000. Example transactor computing devices may include user transactor devices 9002, such as smartphones, tablets, laptop computers, desktop computers, or other computing devices. A user transactor device 9002 may include an operating system 9010 and a plurality of applications, such as a web browser application 9012 and additional applications 9014.

A user transactor device 9002 can include a transaction application 9016 that can transact with a cryptocurrency blockchain network 9018 (hereinafter “cryptocurrency network 9018”) to perform blockchain transactions. The transaction application 9016 can also request consensus trust scores from the trust network 9000. Some example transaction applications may be referred to as “wallet applications.” In some cases, a transaction application may be referred to as a “decentralized wallet application” if the decentralized wallet application does not interact with centralized server-side components.

Additional example transactor devices may be included in intermediate transaction systems 9004. An intermediate transaction system 9004 (e.g., one or more server computing devices) may communicate with the cryptocurrency network 9018, user transactor devices 9002, and the trust network 9000. An intermediate transaction system 9004 can perform cryptocurrency transactions on behalf of the user transactor devices 9002. The intermediate transaction system 9004 can also acquire consensus trust scores from the trust network 9000 on behalf of the user transactor devices 9002. In some implementations, the intermediate transaction system 9004 can provide a user interface for the user transactor devices 9002 (e.g., via a web-based interface and/or an installed transaction application 9016). An example intermediate transaction system 9004 may include a digital currency exchange (e.g., Coinbase, Inc. of San Francisco CA). In some implementations, exchanges may be decentralized.

Additional example transactor devices may be included in automated transaction systems 9006. An automated transaction system 9006 (e.g., one or more server computing devices) may communicate with the trust network 9000 and the cryptocurrency network 9018. Example automated transaction systems 9006 may include payment systems, such as a payment system or gateway that makes recurring payments (e.g., Stripe, Inc. of San Francisco CA or Plaid Inc. of San Francisco CA).

The transactor devices 9002, 9004, 9006 can engage in transactions on the cryptocurrency network 9018. A cryptocurrency network 9018 may be formed by a network of computing devices that each operate according to cryptocurrency blockchain protocols 9020. The cryptocurrency network 9018 may control a cryptocurrency blockchain transaction ledger 9022 (hereinafter “cryptocurrency ledger 9022”). The cryptocurrency ledger 9022 includes a list of transactions between different cryptocurrency blockchain addresses. The cryptocurrency ledger 9022 may also include additional data, such as transaction metadata. Example cryptocurrency networks 9018 may include, but are not limited to, Bitcoin, Bitcoin Cash, Ethereum, and Litecoin. Although a single cryptocurrency network is illustrated in FIG. 90, the trust network 9000 can provide consensus trust scores for addresses on multiple different cryptocurrency blockchain networks using the techniques described herein.

A cryptocurrency ledger 9022 may include cryptocurrency blockchain addresses that identify transactors on the cryptocurrency network 9018. A transactor may refer to a party that controls transactions for a cryptocurrency blockchain address. For example, a transactor may include an individual or an organization, such as a business, a non-governmental organization, or a decentralized autonomous organization. A transactor can control one or more cryptocurrency blockchain addresses on a single cryptocurrency network. A transactor can also have one or more cryptocurrency blockchain addresses on different cryptocurrency networks.

A transactor can initiate a blockchain transaction in which the transactor's blockchain address sends/receives funds to/from another blockchain address. A blockchain address that sends funds to another blockchain address may be referred to herein as a “blockchain sender address” or a “sender address.” The blockchain address that receives funds may be referred to herein as a “blockchain receiver address” or a “receiver address.”

The transactor devices 9002, 9004, 9006 can send trust requests to the trust network 9000 and receive trust responses from the trust network 9000 (e.g., see FIG. 91, FIG. 92, FIG. 93). The trust request may indicate one or more cryptocurrency blockchain addresses for which the transactor would like a trust report (e.g., one or more consensus trust scores). In some implementations, the trust request can include a request payment, such as a blockchain token and/or fiat currency (e.g., United States Dollars). The request payment may be distributed to nodes in the trust network 9000 as payment for providing the consensus trust score(s).

In one example, a transactor device can send a trust request to the trust network 9000 and receive a trust response (e.g., trust report) from the trust network. The transactor device and trust network 9000 may communicate via an application programming interface (API). The trust request may include a cryptocurrency blockchain address for the transactor on the other side of the transaction. For example, a trust request from a sender may request a trust report for the receiver's blockchain address. The sender may make a decision based on the received trust report, such as whether to engage in the cryptocurrency blockchain transaction with the receiver.

FIG. 91, FIG. 92, and FIG. 93 illustrate interactions between different transactor devices/systems 9002, 9004, 9006, the cryptocurrency network 9018, and the trust network 9000. In FIG. 91, the user transactor device 9002 includes a transaction application 9016 (e.g., a wallet application) that transacts with the cryptocurrency network 9018. The transaction application 9016 includes a trust request module 9026 that interfaces with the trust network 9000. For example, the trust request module 9026 can generate the trust request 9030 (e.g., a web request). The trust request module 9026 can also receive the trust response 9032 from the trust network 9000. In some implementations, the trust request module 9026 can generate a graphical user interface (GUI) that the user may interact with in order to send the trust request 9030 and view the trust report 9032.

In FIG. 92, a transactor device 9002 can transact on the cryptocurrency network 9018 via an intermediate transaction system 9004. For example, in FIG. 92, the transactor device 9002 can include a web browser application 9012 that interacts with the intermediate transaction system 9004. The intermediate transaction system 9004 (e.g., a web server) can provide an interface to the web browser 9012 for transacting on the cryptocurrency network 9018. The intermediate transaction system 9004 may also provide an interface (e.g., a web-based interface) for the user to select whether the user wants a trust report before engaging in the blockchain transaction.

In FIG. 93, an automated transaction system 9006 controls transactions on the cryptocurrency network 9018. The automated transaction system 9006 can also request trust reports from the trust network 9000. In some implementations, the transactions engaged in by the automated transaction system 9006 may depend on the consensus trust scores reported by the trust network 9000. For example, the automated transaction system 9006 can engage in transactions if the trust score indicates that the address is unlikely to be engaged in fraudulent activity.

Although the devices/systems described herein may make a trust request 9030 in order to receive consensus trust scores before making a cryptocurrency blockchain transaction, in some implementations, other devices/systems may request consensus trust scores in other scenarios. For example, compliance officers at an exchange may request consensus trust scores for compliance reasons.

Referring to FIG. 94, in some implementations, the trust network 9000 may implement a fraud alert protocol that can automatically notify network participants (e.g., fraud alert requesting devices) of potentially fraudulent cryptocurrency blockchain addresses. For example, a node may include a fraud alert module 9034 that is configured to provide fraud alerts 9036 under a set of fraud alert criteria that may be configured by a user. In one example, a fraud alert module 9034 may monitor one or more cryptocurrency addresses and provide a fraud alert 9036 if the consensus trust score for any address drops below a threshold level of trustworthiness (e.g., as set by a user). In another example, a fraud alert 9036 may be sent if a monitored trust score changes by more than a threshold percentage. In some implementations, a fraud alert protocol may be implemented using a smart contract that monitors a consensus trust score and provides alerts according to a set of business rules that may be defined by a user. In some implementations, a node may be required to stake an amount of UTOKEN to be eligible to receive fraud alerts.

In some implementations, nodes may be connected via a network of state channels. When a cryptocurrency transactor issues a trust request and payment (e.g., UTOKEN), the request can be gossiped until it reaches a node that has the requested consensus trust score. This node can return the consensus trust score to the cryptocurrency transactor. Payment can then be granted according to the reward protocol.

Example transactors may include, but are not limited to, a custodial exchange, a non-custodial exchange, a custodial wallet, a non-custodial wallet, a new token developer and seller, decentralized applications, blockchain enabled merchants, node operators, algorithm suppliers, and proof of work security providers.

A custodial exchange may refer to an entity (e.g., a company) that enables the exchange of cryptoassets while holding the assets on behalf of their customers. Custodial exchanges may use the consensus trust score to evaluate whether depositing cryptoassets are fraudulent, helping to ensure that their service is not used to launder money. Additionally, a custodial exchange may receive alerts to monitor the blockchain addresses they have in custody. A non-custodial exchange may refer to an entity (e.g., company) that enables the exchange of cryptoassets without holding the cryptoassets on behalf of the token purchaser or seller. Non-custodial exchanges may use the consensus trust score to evaluate the trustworthiness of a counterparty.

A custodial wallet may refer to an entity (e.g., a company) that holds private keys on behalf of customers and enables them to send and receive cryptoassets. Custodial wallets may use the consensus trust score to evaluate whether cryptoassets being deposited are fraudulent and to receive fraud alerts. They may also use the consensus trust score to protect their users from sending cryptoassets to fraudulent addresses. A non-custodial wallet may refer to an entity (e.g., a company) that makes software that allows individuals to hold and transact cryptoassets locally on personal devices. Non-custodial wallets may use the consensus trust score to protect their users from sending cryptoassets to fraudulent addresses and from receiving fraudulent funds.

A new token developer and seller may refer to an entity (e.g., a company or individual) that creates software that, when run by a network of peers, creates a new decentralized token. This company may also sell some initial distribution of the token to interested buyers. These transactors may perform an initial coin offering (ICO). A new token developer and seller may use the consensus trust score to ensure funds being used to purchase their token are not fraudulent, ensuring that they are selling tokens in a compliant manner.

A decentralized application may refer to an application that runs on a decentralized network. These may include applications that manage money, applications where money is involved but require another piece, and other applications, which includes voting and governance systems. Decentralized applications may use the consensus trust score for any activity involving the evaluation of counterparty trust, in addition to protecting participants against fraud.

A blockchain-enabled merchant may refer to an entity (e.g., a company) that accepts payment in the form of cryptoassets (e.g., security tokens). Blockchain-enabled merchants may use the consensus trust score to ensure funds being used as payment are not fraudulent. They may also receive alerts on the addresses with which they interact.

Referring back to FIG. 90, the environment includes data sources 9024 that the trust network 9000 may use to determine whether blockchain addresses are fraudulent. Example data sources 9024 described herein include fraud data sources and custody data sources. The trust network 9000 may determine local trust scores based on the data included in the data sources 9024 along with the data included in the cryptocurrency ledger 9022.

FIG. 95 illustrates an example method that describes operation of the environment illustrated in FIG. 90, FIG. 91, FIG. 92, and FIG. 93. For example, the method of FIG. 95 illustrates the determination of local trust scores, candidate trust scores, and a consensus trust score for a single cryptocurrency blockchain address. The method of FIG. 95 may be performed multiple times to determine local trust scores, candidate trust scores, and consensus trust scores for multiple cryptocurrency blockchain addresses.

In block 9100, the nodes 9000 acquire and process fraud and custody data 9024 associated with a cryptocurrency address. In block 9102, the nodes 9000 acquire and process cryptocurrency blockchain data associated with the cryptocurrency address. In block 9104, the nodes 9000 each determine local trust scores for the cryptocurrency address based on the data acquired in blocks 9100-9102.

In block 9106, the nodes 9000 communicate the local trust scores for the cryptocurrency address with one another. After communication of the local trust scores, each of the nodes may include a plurality of local trust scores calculated by other nodes. In block 9108, the nodes 9000 determine candidate trust scores for the cryptocurrency address based on the local trust scores. In block 9110, the nodes 9000 determine a consensus trust score for the cryptocurrency address based on the candidate trust scores for the cryptocurrency addresses. In block 9112, the nodes 9000 can update a distributed consensus trust score ledger to include the calculated consensus trust score. In blocks 9114-9116, the trust network 9000 receives a trust request 9030 for the cryptocurrency address from a requesting device and sends a trust response 9032, including the consensus trust score, to the requesting device.

FIG. 96 illustrates generation of local trust scores. FIG. 97 and FIG. 98 illustrate generation of consensus trust scores. In addition to generating trust scores, the trust network 9000 may implement additional features described with respect to FIG. 99, FIG. 100, and FIG. 101. In some implementations, the trust network 9000 may implement a reputation protocol that calculates and stores reputation values that indicate a variety of parameters associated with the nodes, such as an amount of work performed by the nodes (e.g., see FIG. 99).

In some implementations, the trust network 9000 may implement a token economy that operates as a medium of exchange in the trust network 9000. The token economy described herein uses a token referred to as “UTOKEN.” Each of the nodes may implement a wallet module (e.g., see FIG. 100) that can send, receive, stake, and burn UTOKEN according to the protocols implemented in the trust network.

In some implementations, the trust network 9000 may implement a reward protocol that tracks various parameters of the nodes (e.g., an amount of work) and rewards the nodes using UTOKEN (e.g., see FIG. 100 and FIG. 101). The trust network 9000 may also implement a staking protocol that determines the functionality of the nodes and penalizes certain node behaviors (e.g., the production of fraudulent data).

Different nodes in the trust network 9000 may be configured to implement different features of the trust network 9000. For example, different nodes may be configured to implement different protocols, or portions of protocols, described herein. In some implementations, the staking protocol may determine which features the nodes may implement. The modules and data stores included in the nodes may represent the protocols implemented by the nodes and the data stored by the nodes. Each node may include one or more computing devices. In some implementations, multiple nodes may be run on a single computing device.

FIG. 96 illustrates an example node 9000-1 that includes a trust score determination module 9200 and a local trust data store 9202. The trust score determination module 9200 acquires and processes a variety of data described herein, such as fraud and custody data 9024 along with blockchain data. The local trust data store 9202 can store data for a plurality of cryptocurrency addresses.

The data associated with a single cryptocurrency address is illustrated herein as a blockchain address record 9204. The local trust data store 9202 may include a plurality of such blockchain address records, each for a different cryptocurrency address. Each blockchain address record 9204 can include a blockchain address 9206 that uniquely identifies the record 9204. Each blockchain address record 9204 can also include a local trust score 9208 associated with the blockchain address 9206. The blockchain address record 9204 may include a history of local trust scores calculated over time for the blockchain address.

The blockchain address record 9204 described herein represents data stored in the local trust data store 9202. The node 9000-1 may include a variety of different data structures that are used to implement the data. Accordingly, the blockchain address record 9204 may be implemented using one or more different data structures than explicitly illustrated herein.

In FIG. 96, the trust score determination module 9200 acquires and processes a variety of types of data, such as custody data and fraud data 9024. Example fraud and custody data may include data that provides evidence of fraud with respect to a cryptocurrency address and/or indicates the party that owns/controls the cryptocurrency address. The trust score determination module 9200 may store custody and fraud data related to a cryptocurrency address in the blockchain address record 9204. The trust score determination module 9200 may also generate a fraud label that indicates whether the cryptocurrency address is likely fraudulent based on the acquired fraud data.

The trust score determination module 9200 acquires and processes blockchain data (e.g., the cryptocurrency ledger 9022). The trust score determination module 9200 may store raw and processed blockchain data relevant to a cryptocurrency address in the blockchain address record 9204. Example cryptocurrency blockchain data may include data for a plurality of blockchain transactions between a plurality of different cryptocurrency addresses.

The trust score determination module 9200 determines local trust scores for the cryptocurrency addresses based on the acquired blockchain data and fraud/custody data. In some implementations, the trust score determination module 9200 may generate a blockchain graph data structure based on the blockchain data (e.g., see FIG. 114). The trust score determination module 9200 may also process the graph to determine one or more graph-based values (e.g., importance values) that may be used to generate local trust scores.

In some implementations (e.g., see FIG. 115), the trust score determination module 9200 may generate scoring features for cryptocurrency addresses and generate one or more scoring models based on the scoring features and other data (e.g., labeled fraud data). In these implementations, the trust score determination module 9200 may generate one or more local trust scores for blockchain addresses using one or more scoring models and the scoring features associated with the blockchain addresses. FIGS. 109-116 illustrate a more detailed implementation of the trust score determination module 9200 and the local trust data store 9202.

A plurality of nodes can communicate with one another in order to come to a consensus trust score for a cryptocurrency address. Each node may be identified (e.g., uniquely identified) by a node identifier (ID). In some implementations, a public/private key pair is generated upon inception of a node. In these implementations, a node's public key may serve as a node ID, although other identifiers may be used.

Different nodes may compute the same/similar local trust scores in cases where the different nodes have access to the same/similar cryptocurrency blockchain data and fraud/custody data. In some cases, the local trust scores may differ among nodes. For example, the local trust scores may differ when nodes have access to different fraud and custody data. In a specific example, nodes located in different jurisdictions (e.g., countries) may have access to data sources that are blocked in other jurisdictions. In another specific example, some nodes may access information at different rates.

The nodes 9000 implement a trust consensus protocol that determines consensus trust scores for cryptocurrency addresses. The consensus trust scores can be stored in a consensus trust score ledger 9300 that is distributed to nodes across the trust network 9000. FIG. 97 illustrates an example node 9000-1 that includes a consensus determination module 9210 and a trust consensus data store 9212 (hereinafter “consensus data store 9212”). The trust network 9000 can include a plurality of nodes that include the functionality described with respect to FIG. 97 and FIG. 98. The consensus determination module 9210 can communicate with other consensus determination modules (e.g., via communication module 9210-1) of other nodes to determine consensus trust scores. The consensus data store 9212 includes the consensus trust scores and other data in a consensus trust score ledger 9300.

The consensus determination module 9210 can communicate with other nodes (e.g., consensus modules of other nodes). For example, each node may communicate its local trust score to other nodes via outgoing trust consensus messages 9302. Additionally, each node may receive local trust scores from other nodes via incoming trust consensus messages 9304. An example trust consensus message may include a node ID, a node IP address, a cryptocurrency blockchain address and an associated local trust score. In some cases, instead of indicating an associated local trust score, a trust consensus message may indicate that a local trust score has not been calculated or is in the process of being calculated.

The consensus determination module 9210 can generate a local trust score list 9306 (“trust score list 9306”) based on the local trust scores received from other nodes (e.g., using list building module 9210-2). The trust score list 9306 may include a list of node IDs and corresponding local trust scores for a cryptocurrency address. The consensus determination module 9210 may generate a local trust score list 9306 for each cryptocurrency address. Each node can communicate its trust score list to other nodes. For example, a node can send/receive trust score messages that include trust score lists. A node can update the local trust score list based on other received trust score lists.

Each node in the trust network 9000 may be configured to communicate with different sets of nodes. Put another way, nodes in the trust network 9000 may be configured to communicate with non-overlapping sets of nodes. Since different nodes may communicate with different sets of other nodes, eventually, each of the nodes communicating local trust scores with one another may have knowledge of other nodes' local trust score calculations. In this scenario, different nodes may include similar trust score lists. In some examples, the trust scores in the trust score lists may converge in fractions of a second or a matter of seconds.

The trust score list 9306 for a cryptocurrency address may include a frequency (count) distribution of local trust scores. In some cases, the trust score list 9306 may include a large number of local trust scores within a tight grouping. In some cases, a trust score list 9306 may include outlier trust scores that have values outside of a major grouping. For example, an outlier may be due to variations in information used to produce the local trust scores. As another example, one or more outliers may be caused by nodes that are producing/distributing fraudulent trust scores. As described herein, nodes that produce/distribute fraudulent trust scores may be held accountable (e.g., via burning of staked funds).

The consensus determination module 9210 determines a candidate trust score based on the local trust scores included in the trust score list 9306 (e.g., using candidate determination module 9210-3). In some implementations, the consensus determination module 9210 may include “candidate determination criteria” that trigger the determination of a candidate trust score. Example candidate determination criteria may include the presence of local trust scores for a threshold number of nodes and/or a threshold fraction of nodes. For example, the consensus determination module 9210 may determine a candidate trust score in response to the presence of a threshold number/fraction of local trust scores included in the trust score list.

In some implementations, the consensus determination module 9210 may determine a candidate trust score in response to the distribution pattern of trust scores in the trust score list. For example, the consensus determination module 9210 may be triggered to determine a candidate trust score when the trust scores are centered in a distribution (e.g., tightly centered in a single distribution). If the trust score distribution includes outliers, the consensus determination module 9210 may continue communicating local trust scores with the other nodes. In a specific example, the consensus determination module 9210 may be triggered to determine a candidate trust score when the variance of a distribution is less than a threshold variance. In cases where there are multiple modes of distribution, the consensus determination module 9210 may determine whether the modes are valid or whether the modes are due to fraudulent trust scores. Similarly, if the variance of the distribution is too great (e.g., greater than a threshold value), the consensus determination module 9210 may determine whether the variance is due to variations in calculations and/or fraudulent behavior. The consensus determination module 9210 may filter out (i.e., remove) trusts scores that are attributable to fraudulent behavior before determining a candidate trust score.

The consensus determination module 9210 can determine the candidate trust score using a variety of techniques. In some implementations, the consensus determination module 9210 may remove outlier local trust scores from the trust score list before determining the candidate trust score. The consensus determination module 9210 may determine the candidate trust score based on an average (e.g., a blended average) of the remaining local trust scores in the trust score list 9306. For example, the consensus determination module 9210 may determine the candidate trust score by using a statistically weighted average of local trust scores based on node count.

The nodes may communicate the candidate trust scores between one another. The nodes may also store the candidate trust scores 9308. A set of consensus determination modules can determine a consensus trust score for a cryptocurrency address based on a plurality of candidate trust scores 9308. In some implementations, consensus determination modules may monitor the candidate trust scores to determine whether the candidate trust scores are converging on a similar trust score. The consensus determination modules may be configured to determine a consensus trust score in response to one or more consensus triggers associated with the candidate trust scores. For example, the consensus determination modules may be configured to determine a consensus trust score if greater than a threshold number/fraction of candidate trust scores are in agreement (e.g., within a threshold variance).

In some implementations, the consensus determination modules may perform validation operations associated with the candidate trust scores (e.g., using validation module 9210-4). For example, the consensus determination modules may perform error checking of the candidate trust scores. The error checking operations may include verifying whether communication of local trust scores actually occurred for the candidate scores or whether a conspiracy occurred that led to the candidate scores. In some implementations, the consensus determination modules can query a plurality of nodes that participated in communication of local trust scores and determination of candidate scores to determine what the plurality of nodes communicated to one another. In some implementations, the nodes may elect a leader node to perform the error checking operations and determine whether the nodes are in agreement.

After validating the candidate trust scores, the consensus determination module 9210 may calculate the consensus trust score. In some implementations, the consensus determination modules may determine the consensus trust score based on an average (e.g., a blended average) of the candidate trust scores. For example, the consensus determination modules may determine the consensus trust score by using a statistically weighted average of candidate trust scores based on count. The consensus determination module 9210 may then update the consensus ledger 9300 with the consensus trust score. The consensus determination module 9210 may then distribute the updated ledger to other nodes (e.g., using the ledger update module 9210-5). In some implementations, only a subset of the nodes can write trust scores and other data to the consensus ledger 9300, although nodes that do not participate in generating the consensus ledger 9300 may receive updated versions of the consensus ledger 9300.

The consensus ledger 9300 includes consensus trust scores for different cryptocurrency addresses over time. The consensus trust scores included in the consensus ledger 9300 may be provided to trust score requestors. The consensus ledger 9300 can also include timing data that indicates when the consensus trust scores were written to the ledger 9300. For a determined consensus trust score, the consensus ledger may include validation information associated with the consensus trust score, such as the candidate trust scores used for the consensus trust score and the nodes that were validated. Storing the validation information for a consensus trust score may allow the nodes to review how the consensus trust scores were validated.

The nodes 9000 may be configured to generate new trust scores for new cryptocurrency addresses and update the trust scores over time. For example, the trust score determination modules may be configured to generate/update local trust scores for cryptocurrency addresses. As another example, the consensus determination modules may be configured to generate/update candidate trust scores and consensus trust scores over time. The frequency of updates can be set by the consensus protocol. In some cases, data associated with cryptocurrency addresses may change over time. In some cases, data included in the cryptocurrency blockchain may change over time. The trust score determination modules and consensus determination modules may be configured to generate new trust scores in response to such changes in data.

In some implementations, the consensus determination modules may communicate new local trust scores and/or updated local trust scores to other nodes. For example, the consensus determination modules may communicate updates in local trust scores to other nodes if the update resulted in greater than a threshold amount of change in the local trust score. Updates to the local trust scores may cause changes in candidate trust scores. In turn, changes to candidate trust scores may cause a change in consensus trust scores and the consensus ledger. In this manner, the consensus ledger 9300 may reflect the history of consensus trust scores over time for a plurality of cryptocurrency addresses.

Different nodes may have different levels of functionality with respect to the calculation of trust scores. The differing functionality may be based on the amount of value (e.g., UTOKEN) staked by the nodes, where a greater staked amount can authorize more functionality. In some implementations, all nodes may be authorized to buy trust scores and include copies of consensus ledgers. In these implementations, a subset of nodes may be configured to calculate local trust scores, candidate trust scores, and consensus trust scores. Additionally, the subset of nodes, or a further subset, may be configured to write consensus trust scores to the consensus ledger.

FIG. 98 illustrates an example method that describes calculation of a consensus trust score from the perspective of an example node 9000-1. The method of FIG. 98 may be performed multiple times to determine local trust scores, candidate trust scores, and consensus trust scores for multiple cryptocurrency blockchain addresses.

In blocks 9310-9312, the trust score determination module 9210 acquires and processes fraud and custody data 9024 and cryptocurrency blockchain data. In block 9314, the trust score determination module 9210 determines a local trust score for a cryptocurrency address. In block 9316, the consensus determination module 9210 receives local trust scores from other nodes. In block 9318, the consensus determination module 9210 sends local trust scores to other nodes.

In block 9320, the consensus determination module 9210 determines whether to calculate a candidate trust score (e.g., based on candidate determination criteria). If the candidate determination criteria are not satisfied, the consensus determination module 9210 may continue communicating local trust scores with other nodes in blocks 9316-9318. If the consensus determination module 9210 determines that the candidate determination criteria are satisfied, in block 9322, the consensus determination module 9210 may determine a candidate trust score based on the local trust scores in the trust score list 9306. In block 9324, the consensus determination module 9210 may determine a consensus trust score based on a plurality of candidate trust scores. In block 9326, the consensus determination module 9210 may update the consensus trust ledger 9300 to include the consensus trust score.

Referring to FIG. 99, the trust network 9000 may implement a reputation protocol in which a plurality of nodes each may compute one or more reputation values. The reputation values for a node may indicate a variety of parameters associated with the node, such as an amount of work the node performed during trust score calculations and distribution, the quality of the work performed (e.g., the accuracy), and the consistency of node operation (e.g., node uptime). The reputation values may be used by other protocols in the trust network 9000. For example, nodes may determine candidate and/or consensus trust scores based on the reputation values associated with one or more nodes. As another example, the nodes may be awarded and/or punished according to their reputation values.

The node 9000-1 includes a reputation determination module 9400 that determines reputation values for the node. In some implementations, the nodes 9000 can transmit reputation messages 9404-1, 9404-2 to other nodes. The reputation messages 9404 can include reputation data, such as reputation values associated with one or more nodes. In this manner, each node may receive reputation values for a plurality of other nodes. In a specific example, each node can be configured to communicate reputation data with a set of other nodes. In this specific example, each node can directly request reputation data from any node in the set of nodes. Additionally, each node may also request reputation data for a plurality of other nodes from any node in the set of nodes.

The node includes a reputation data store 9402 that stores reputation data for a plurality of nodes (e.g., a subset of nodes on the trust network). The reputation data may be stored in a reputation ledger 9406 that includes a plurality of node IDs along with associated reputation values. The reputation data store 9402 may also store additional information 9408, such as data used for generating reputation values and data associated with generating the consensus trust scores.

The reputation determination module 9400 can determine a plurality of different reputation values for each node. In some implementations, the reputation determination module 9400 may determine one or more work reputation values for the amount of work a node performs with respect to calculating trust scores. For example, the reputation determination module 9400 may determine one or more reputation values based on the number of local trust scores calculated, the number of candidate trust scores calculated, and the amount of work related to calculating consensus trust scores. One or more work reputation values may also be based on an amount of communication (e.g., trust consensus messages) performed by the node.

The reputation determination module 9400 may also determine a plurality of quality reputation values for nodes based on the quality of the calculations performed by the nodes. For example, the quality reputation values may be based on a number of trust score outliers produced by the nodes and how fast trust scores were produced. The reputation determination module 9400 may also determine a plurality of distribution reputation values for nodes based on the distribution of consensus trust scores to requestors and the distribution of trust scores as fraud alerts.

The reputation determination module 9400 may also determine a plurality of node performance reputation values based on a variety of node parameters, such as node bandwidth, node processing power, node throughput, and node availability. Example reputation values associated with node availability may be based on uptime values, mean time between failure (MTBF) values, and/or mean time to repair (MTTR) values.

The reputation determination module 9400 may determine one or more data storage reputation values based on the amount of data (e.g., historic data) stored at a node and the amount of time for which the data is stored. The reputation determination module 9400 may also determine one or more reputation values that indicate an amount of time the node has been included (e.g., online) in the trust network 9000. The reputation determination module 9400 may determine one or more staking reputation values based on the amount staked by a node. Additionally, the reputation determination module 9400 may determine one or more outlier reputation values that indicate a number of outliers associated with a node and whether the outliers were considered fraudulent or supported by evidence.

In some implementations, the reputation determination module 9400 may calculate one or more composite reputation values, each of which may be a function of any individual reputation values described herein. For example, a composite reputation value may be a weighted calculation of one or more component reputation values.

The reputation data store 9402 may store information in addition to the reputation ledger. For example, the reputation data store 9402 may store historic trust score data or other data used to determine the reputation values. In one example, the reputation data store 9402 may store a history of each of the trust scores and contribution to the trust scores from each node. In a more specific example, the historical data may include the number of nodes that participated in the consensus calculation, the range of scores used in the calculation, along with other factors upon which the consensus scores were based.

In some implementations, the consensus determination module 9210 can determine candidate trust scores and/or consensus trust scores based on one or more reputation values. For example, the consensus determination module 9210 may determine whether a trust score is an outlier based on the reputation associated with the node. In some implementations, the consensus determination module 9210 may consider reputation values during validation operations.

Referring to FIG. 100, in some implementations, the trust network 9000 may implement a token economy that operates as a medium of exchange in the trust network 9000. For example, the trust network nodes may include utility token modules 9500 that implement a utility token protocol 9502. The utility token protocol 9502 may be powered by a token (e.g., a native utility token). The utility token may be assigned a name (e.g., a coined name). For example, the utility token may be referred to herein as “UTOKEN,” although other names may be used.

The trust network 9000 includes a utility token blockchain ledger 9506 that may be stored in utility token data stores 9504 across the nodes. The utility token ledger 9506 may be a version of a public transactional ledger integrated into the trust network 9000. The utility token ledger 9506 may include a list of UTOKEN transactions between different utility token blockchain addresses. For example, the utility token ledger 9506 may indicate the various transactions associated with the nodes 9000, such as the purchase of UTOKEN, purchase of trust scores, payment into the reward protocol, rewards paid by the reward protocol, and amount of funds staked by the nodes. The utility token ledger 9506 may also include additional data, such as transaction metadata.

UTOKEN can be used in a variety of ways on the trust network 9000. In some implementations, UTOKEN can be used as payment for access to trust scores and fraud alerts. In some implementations, UTOKEN can be used to reward nodes for performing work. In some implementations, a node may stake UTOKEN in order to enable additional functionality within the trust network 9000. Although UTOKEN is described herein as a medium of exchange in the trust network 9000, other payment types may be used as a medium of exchange in the trust network 9000. For example, other types of payments/tokens may be used for acquiring trust scores, acquiring fraud reports, paying rewards, and staking. In some implementations, the utility token modules 9500 may implement smart contracts for the trust network 9000. Communication between the nodes during implementation of the utility token protocol is illustrated at 9501.

Initially, the trust network 9000 may include a set number of UTOKEN. For example, there may initially be 1,000,000,000 UTOKEN. UTOKEN may be initially granted and/or sold to nodes. In some implementations, the supply of UTOKEN may expand in a deflationary manner, which may track economic indicators including the total number of nodes, transaction volume, staking amount, and fractionalization of the UTOKEN token.

Each node may include a wallet module 9514 that can be used to perform transactions on the utility token blockchain 9506. The wallet module 9514 may implement a variety of functionalities. In some implementations, the wallet module 9514 may be used to purchase trust scores. Payments for trust scores may be put into the reward protocol, as described herein. In some implementations, the wallet module 9514 may be used to send/receive UTOKENS (e.g., with other nodes). In some implementations, the wallet module 9514 can be used to stake UTOKEN. In some implementations, the wallet module 9514 can lock UTOKEN, thereby indicating to the trust network 9000 that the locked UTOKEN are not available to be sent until unlocked. In some implementations, the wallet module 9514 can be used to burn UTOKEN. Burning UTOKEN may prevent the burnt UTOKEN from being used for any function in the future.

The trust network 9000 may implement a reward protocol that receives payments for a variety of activities, such as purchasing a trust score and purchasing fraud alerts. The trust network 9000 may pay out UTOKEN to nodes (e.g., node wallets) based on a variety of factors. The nodes include reward modules 9508 and reward data stores 9510 that implement the reward protocol. For example, the reward modules 9508 can receive UTOKEN payments and pay out UTOKEN as a reward payment to nodes (e.g., according to work performed). The reward data store 9510 may store a reward ledger 9516 that indicates the nodes that received reward payments along with the corresponding factors (e.g., work performed) associated with the reward payments. For example, the reward ledger 9516 may provide an accounting of the amount of UTOKEN received by the reward protocol, the calculation of the rewards, and the amount of UTOKEN paid out to different nodes in response to the calculations. UTOKEN payments associated with the reward protocol may be stored according to one or more reward addresses on the utility token ledger 9506.

The reward protocol can receive UTOKEN from a variety of sources. For example, the reward protocol can receive UTOKEN that was used to purchase trust score reports. As another example, the reward protocol can receive UTOKEN used to purchase fraud alerts.

The reward protocol can make reward payouts to nodes based on a variety of factors associated with the nodes. In some implementations, the reward protocol may pay rewards to nodes based on reputation values associated with the nodes. The reward protocol can examine one or more reputation ledgers 9406 to determine the reputation values associated with the nodes. The reward payout calculations may be a multifactor calculation that includes one or more reputation values. The reward calculations and payments may be performed periodically in some cases.

In some implementations, the reward protocol may pay rewards based on one or more work reputation values that indicate an amount of work a node performed with respect to calculating/communicating trust scores. The reward protocol may pay a larger portion of rewards for nodes that perform more work with respect to calculating and communicating trust scores. In some implementations, the reward protocol may pay rewards based on one or more quality/distribution reputation values for nodes based on the quality of the calculations performed by the nodes. The reward protocol may pay a smaller portion of rewards for nodes that produce outlier trust scores.

In some implementations, the reward protocol may pay rewards based on one or more distribution reputation values for nodes based on the distribution of consensus trust scores to requestors and the distribution of trust scores as fraud alerts. The reward protocol may pay a larger portion of rewards for nodes that distribute a greater amount of trust scores. In some implementations, the reward protocol may pay rewards based on one or more performance reputation values. For example, the reward protocol may pay larger rewards to nodes with greater bandwidth, processing power, throughput, and availability.

In some implementations, the reward protocol may pay rewards based on one or more data storage reputation values. For example, the reward protocol may pay larger rewards to nodes that store more data. In some implementations, the reward protocol may pay rewards based on one or more reputation values that indicate an amount of time the node has been included (e.g., online) in the trust network 9000. For example, the reward protocol may pay larger rewards to nodes that have been online for a longer period of time in the trust network 9000. In some implementations, the reward protocol may pay rewards based on one or more staking reputation values. For example, the reward protocol may pay larger rewards to nodes that have staked more UTOKEN.

In some implementations, algorithm suppliers may be rewarded in UTOKEN for providing nodes that contribute algorithms to the ecosystem. In some implementations, proof of work security providers that may validate the UTOKEN ledger using a proof-of-work consensus algorithm may receive UTOKEN as a block reward to incentivize their participation in the ecosystem. Communication between the nodes during implementation of the reward protocol is illustrated at 9503.

FIG. 101 illustrates an example method that describes operation of the reward protocol. In block 9600, the reward protocol receives payments for trust scores and fraud alerts. In block 9602, the reward protocol retrieves reputation values for a plurality of nodes. In block 9604, the reward protocol determines reward payouts to the plurality of nodes based on the reputation values associated with the nodes. In block 9606, the reward protocol pays the nodes according to the determined payouts. In block 9608, the reward protocol updates the reward ledgers 9516 to reflect the payment calculations (e.g., based on reputation values) and the payment amounts. The reward protocol may periodically repeat the method of FIG. 101 so that the nodes may be periodically rewarded for their relative contributions to the trust network 9000.

The trust network 9000 may implement a staking protocol (e.g., using staking modules 9512) in which each node can stake an amount of UTOKEN. The amount of UTOKEN staked may determine the level of functionality afforded to the node. The staked UTOKEN can be reflected in the utility token ledger 9506.

Staked UTOKENs may be under the temporary control of the trust network 9000. For example, in some implementations, the reward protocol may penalize a node by removing staked UTOKEN. In some implementations, the staking functionality may be implemented as a smart contract in which violation of the contract results in the surrender (e.g., burning) of some staked UTOKEN. In these implementations, fulfillment of the smart contract results in the UTOKEN being returned to the staking party. In some implementations, the reward protocol may penalize a node for producing outlier trust scores if the outlier scores are determined to be fraudulent.

In some implementations, a node can be formed when a network participant stakes a quantity of UTOKEN (e.g., a required quantity). The amount of UTOKEN staked by a node may determine the amount of functionality that may be implemented by the node. For example, staking more UTOKEN may allow a node to implement a greater amount of network functions. In these cases, nodes may be assigned different levels of functionality. A lower level node may have functionality that is limited to requesting trust scores. Higher level nodes may participate in calculating local trust scores, candidate trust scores, and consensus trust scores. There may be any number of node levels that may perform any number of services on the trust network 9000. If the trust network penalizes a node and burns the node's stake, the node may descend in level and lose the corresponding functionality. Communication between the nodes during implementation of the staking protocol is illustrated at 9505.

In some implementations, the cost a node is required to pay for a trust score may decrease as the amount of UTOKEN staked by the node increases. In these cases, the more a node stakes, the fewer UTOKEN is required for acquiring a trust score (e.g., via real-time reporting). An example relationship of staked UTOKEN and consensus trust score cost is described in the table of FIG. 105. In one specific example, to be eligible for the discount, the staked amount of UTOKEN may be required to be staked for a period of time (e.g., at least 90 days).

FIG. 102 and FIG. 103 illustrate example GUIs that may be generated on a user transactor device 9002 by the transaction application 9016 or the intermediate transaction system 9004. The illustrated GUIs may be for a sender in a cryptocurrency transaction. It can be assumed that the cryptocurrency network on which the blockchain transactions occur in FIG. 102 and FIG. 103 use units of “coins” for transactions. The top portion of the GUIs includes fields that indicate the sender's information, such as the sender's blockchain address and their balance (e.g., 100 coins). The top portion of the GUIs also include fields in which the sender can specify a receiver address and indicate the transaction amount (e.g., 5 coins) for the potential transaction. The GUIs include a “Send Coins” GUI element that can initiate the specified transaction between the sender and the receiver.

The lower portion of the GUIs in FIG. 102 and FIG. 103 provide the sender with the option of acquiring a trust report from the trust network 9000 before engaging in the transaction. For example, in FIG. 102, the user can select (e.g., touch/click) the “Request Trust Report” GUI element to send a trust request to the trust network 9000. The trust request may include the receiver's address, as specified in the “To:” box above. FIG. 103 illustrates an example trust report received in response to the trust request.

In FIG. 103, the received trust report indicates that the receiver had a trust score of −0.90. It can be assumed in this case that a negative valued trust score near −1.00 indicates that the receiver address is likely fraudulent. Similarly, a positive valued trust score near 1.00 may indicate that the receiver address is not likely fraudulent. In addition to the numeric score of −0.90, the trust report also summarizes the meaning of the trust score number. Specifically, the trust report indicates that the “trust score indicates that the receiver has likely engaged in fraudulent activity.” The GUI also provides a “Cancel Transaction” GUI element that the sender may select (e.g., touch/click) to cancel the specified transaction.

In some implementations, the sender may be charged an amount for requesting the consensus trust score. In implementations where the sender is transacting via an exchange, the exchange may spend UTOKEN into the reward protocol to retrieve the consensus trust score. In implementations where the sender does not interact via an intermediate transaction system 9004, the sender may purchase UTOKEN from the trust network 9000 for use in acquiring a consensus trust score.

FIG. 104 illustrates an example in which the trust network 9000 is queried as part of a payment insurance process. In FIG. 104, the user transactor device 9002 transacts on the cryptocurrency blockchain network 9018 via an intermediate transaction system. The intermediate transaction system 9810 includes a trust request module 9026 that can retrieve trust reports from the trust network 9000. The intermediate transaction system 9810 may also provide payment insurance to the transactor.

The intermediate transaction system 9810 of FIG. 104 includes a payment insurance module 9812 that may determine whether a transaction will be insured. The terms on which transactions are insurable may be agreed to by the owner/operator of the intermediate transaction system 9810 and the owner/operator of the payment insurance system 9814 (e.g., an underwriter system). In some implementations, payment insurance may be provided for transactions in which the transacting blockchain addresses have trust scores that indicate a low likelihood of fraud. The payment insurance system 9814 can acquire data related to the transactions (e.g., trust scores, timing, etc.) for auditing purposes.

In FIG. 104, initially, the transactor device 9002 may initiate a transaction with the intermediate transaction system 9810. In response to the initiated transaction, the intermediate transaction system 9810 (e.g., the trust request module 9026) may retrieve a trust report for the receiver and/or the sender. The intermediate transaction system 9810 may then determine whether the transaction is insurable. For example, the payment insurance module 9812 may determine whether the transacting blockchain addresses have trust scores that indicate a low likelihood of fraud. In some implementations, the payment insurance module 9812 may compare consensus trust scores to trust score threshold values that indicate a maximum tolerable likelihood for fraud. In these implementations, the payment insurance module 9812 may indicate that the transaction is insurable if the consensus trust score(s) are less than the trust score threshold value. If the consensus trust score(s) are greater than the tolerable level for fraud, payment insurance may be declined.

In some implementations, the payment insurance module 9812 may query the payment insurance system 9814 to determine whether the transaction is insurable. The query may indicate the consensus trust scores for the transacting parties. In these implementations, the payment insurance system 9814 can make the determination of whether to insure the transaction. The payment insurance system 9814 may then notify the intermediate transaction system 9810 of whether the transaction is insurable.

In addition to the trust network 9000 playing a part in payment insurance processes, the trust network 9000 may also play a role in other financial processes. For example, the trust scores/reports generated by the trust network 9000 may be used in order to freeze transactions and/or clawback funds.

The trust network 9000 may include any number of nodes. As described herein, the nodes 9000 may have different levels of functionality (e.g., based on stake). The levels of nodes may be variable and different levels of nodes may be eligible to participate in different services. FIG. 106 illustrates example services associated with three different levels of nodes.

In some implementations, level 1 nodes may stake a minimum quantity of UTOKEN, X, for a period of time (e.g., at least 90 days). Level 1 nodes may perform all node activities in some implementations. In addition to performing updates to trust scores and participating in real-time reporting, a level 1 node may participate in trust score processing and the trust quorum, gathering and validating evidence of fraud and custody, and sending transactors fraud alerts. Level 1 nodes may be the most important nodes in some implementations. In some cases, to maintain the security of the trust network, there should be a minimum number of level 1 nodes (e.g., 9000 level 1 nodes). A decentralized autonomous organization (DAO) may include a mandate to run additional level 1 nodes in the event that the minimum is not met.

In some implementations, level 2 nodes may stake the minimum quantity of UTOKEN (e.g., proportional to X/2) for a period of time (e.g., at least 90 days) to perform trust score updates and participate in the trust quorum. Level 2 nodes may additionally update the UTOKEN ledger, add evidence of custody to the blockchain, and deliver fraud alerts. Level 3 nodes may stake the minimum quantity of UTOKEN (e.g., proportional to X/5) for a period of time (e.g., at least 90 days) to validate fraud and custody evidence.

Trust report requests can be stored in a node's transaction mempool for processing and prioritization. Each node level may have a separate transaction mempool. Level 3 nodes, for example, may not store report requests in some implementations. Level 1, however, may store report requests (e.g., state channel updates). In some implementations, nodes that participate in fraud and custody verification can use separate mempools for those purposes.

Nodes may earn rewards for performing services. For example, nodes may earn rewards proportional to their level. When a cryptocurrency transactor accesses a trust score, the UTOKEN may be split between the awarded nodes. Additionally, when a block is secured in the utility token blockchain, nodes may earn a percentage (e.g., 45%) of the mining reward.

A node level can have a respective reward queue. The amount of the mining reward (e.g., 45% of the mining reward) each node receives can be proportional to the amount they staked (e.g., their node level). When a node joins the trust network 9000, it may be placed at the bottom of the queue. It may go up the queue so long as it actively provides service on the trust network 9000 (e.g., proof of service). When it reaches the top of the queue (e.g., top 10%), it may be eligible for reward selection. In a specific example, the probability of random selection may be 1/n, where n is the number of nodes in the top 10% of the queue.

In a specific implementation, the target par value for the cost of node services may be 1 UTOKEN, while the par value of node earnings may be 1.2 UTOKEN. In this specific implementation, the consensus trust score prices are set above cost to help ensure rewards for nodes.

A node contribution program can enable nodes to co-develop algorithms for the consensus trust score. This program may be a path to contribution that allows nodes to better the accuracy of the algorithm (e.g., predictive algorithm) that assigns trust scores. The program may allow the network to evolve to best fit new use cases and exploits on the blockchain. Rewards to contributors may be controlled by the DAO through a bounty program.

The utility token protocol may be governed by a DAO. The DAO may allow the protocol to keep pace with new developments. Participants may use UTOKEN to vote in the DAO. The DAO may be funded with an endowment of the initial token supply (e.g., 5%) and receive a percentage of mining rewards (e.g., 10% of every mining reward). If the number of level 1 nodes falls below a set number (e.g., 9000), the DAO may run the minimum required nodes using DAO funds.

The DAO may determine protocol updates including adjusting supply coefficients, setting bounties to update the protocol, improving or adjusting existing integrations with partners, and accepting work when it is done. The DAO may assign and reward the bounty program. If malicious actors attempt to exploit the trust network 9000, a bug bounty for algorithms may be opened to address that particular pattern, thereby strengthening the whole ecosystem. The DAO may additionally approve changes to open source bot software.

The DAO may control key system variables, including the number of UTOKEN staked per node level, staking period, and cryptocurrency transactor discounts per staking amount.

Correctly proportioned node staking may enable a healthy token economy. The DAO may adapt the protocol to ensure there is enough UTOKEN in circulation to facilitate transactions and sufficient staking to promote a healthy and balanced token velocity. FIG. 108 illustrates sample UTOKEN staking amounts and number of level 1 nodes. For example, the chart may describe example node numbers for when there is between 35 percent and 50 percent of UTOKEN in circulation.

Nodes may separate the work of updating trust scores into cliques based on the organic underlying graph topology of the blockchain. Cliques can then be assigned to nodes to update and report on. The separation of the graph into cliques may prevent individual nodes from having full access to all of the trust data. This may protect the integrity of the token economy while still maintaining a full graph. There may be an overlap of addresses within cliques. As the number of nodes increases, clique overlap may increase.

The table of FIG. 107 illustrates an example relationship of the number of nodes, the number of cliques, the address overlap, and the probability that a node will get a single address in their control. Here, overlap may scale with the number of nodes. The security of the trust network 9000 may scale with the number of nodes on the trust network 9000. The maximum probability of a node getting a specific address is 5%, with a minimum of 5 overlapping addresses per clique.

The probability of a node getting a single address may be determined by: P (Address A)=(number of cliques with Address A)/(total number of cliques).

However, the probability of getting control of a specific address may be different than the probability of getting control of any address. If a participant only has one node, that participant cannot get control over a single address, since other nodes contain that address in their cliques as well.

The high cost to become a node may be one way the network prevents Sybil attacks. Because clique placement may be pseudo-random, in some cases, a malicious actor must control 51% of the nodes on average to have 51% control over a single address.

A hypergeometric distribution described below may be used to calculate the probability of a node randomly getting 51% control of a single address or any address.

$$N = Number of nodes$$

$$B = Bad nodes ( who want to control address )$$

$$O = Overlap$$

$$C = Number of nodes to control for 51 \% = ( O / 2 ) + 1$$

$$P ( control over a specific address ) = {\prod }_{k = C}^{O} \frac{( B choose k ) ( ( N - B ) choose ( O - k ) )}{( N choose O )}$$

The more nodes there are and the higher the cost of UTOKEN, the more difficult it is to mount such an attack. For the base case of 9000 nodes with 5 overlap, the probability of getting 51% control of an address may be: P(51% control)=P(3 nodes gain control over address)+P(4 nodes gain control over address)+P(5 nodes gain control over address)=Πₖ₌₃⁵ (5 choose k) (95 choose 5−K)/(100 choose 5)=6.2e-05.

When the number of cliques increases to 1,000, and overlap increases to 50, the probability becomes 1.7e-10. As the number of nodes and cliques increase, the probability of a 51% attack to control the trust score of any single address approaches 0.

FIG. 109 is an example detailed functional block diagram of the trust score determination module 9200 (hereinafter “trust module 9200”) and the local trust data store 9202. FIG. 110 is a method that describes operation of the trust module 9200. Referring to FIG. 109, the trust module 9200 acquires and processes a variety of data described herein. The processed data can be included in the local trust data store 9202. The data associated with a single cryptocurrency blockchain address is illustrated herein as a blockchain address record 9204. A record data store 9710 may include a plurality of such blockchain address records 9204, each for a different blockchain address. Each blockchain address record 9204 can include a blockchain address 9206 that uniquely identifies the record. The blockchain address record 9204 described herein represents data stored in the local trust data store 9202. The local trust data store 9202 may include a variety of different data structures that are used to implement the data. Accordingly, the blockchain address record 9204 may be implemented using one or more different data structures than explicitly illustrated herein.

FIG. 110 is a method that describes operation of the trust module 9200 illustrated in FIG. 109. In block 9730, the data acquisition and processing module 9700 acquires and processes a variety of types of data 9024, such as custody data and fraud data (e.g., see FIG. 111). The data acquisition and processing module 9700 may store custody and fraud data 9718 related to a blockchain address in the blockchain address record 9204. The data acquisition and processing module 9700 may also generate a fraud label 9720 that indicates whether the blockchain address is likely fraudulent based on the acquired fraud data.

In block 9732, the blockchain acquisition and processing module 9702 acquires and processes blockchain data (e.g., the blockchain ledger 9022) (e.g., see FIG. 112). The blockchain acquisition and processing module 9702 may store raw and processed blockchain data 9722 relevant to a blockchain address in the blockchain address record 9204. In block 9734, the graph generation and processing module 9704 generates a blockchain graph data structure based on the blockchain data (e.g., see FIG. 113 and FIG. 114). The blockchain graph data structure may be stored in the graph data store 9712. The graph generation and processing module 9704 may also process the graph to determine one or more graph-based values 9724 (e.g., importance values) that may be used to generate local trust scores.

In block 9736, the feature generation module 9706 generates scoring features 9726 for blockchain addresses (e.g., see FIG. 115). In block 9738, the scoring model generation module 9708 generates one or more scoring models based on the scoring features and other data (e.g., labeled fraud data). The one or more scoring models may be stored in the scoring model data store 9714. In block 9740, the score generation module 9716 generates one or more local trust scores 9208 for blockchain addresses using one or more scoring models and the scoring features associated with the blockchain addresses (e.g., see FIG. 116). Data related to the requests and responses for consensus trust scores may be stored as request data 9728 of the blockchain address record 9204.

Detailed examples of the trust module 9200 and the local trust data store 9202 are now described with respect to FIG. 111, FIG. 112, FIG. 115, and FIG. 116. Various modules and data stores have been omitted from the figures for illustration purposes only. For example, the various modules and data stores have been omitted to focus on the functionality associated with the modules and data stores that are illustrated.

FIG. 111 illustrates data acquisition and processing of fraud and custody data sources. FIG. 112 illustrates acquisition and processing of blockchain data. FIG. 113 and FIG. 114 illustrate generation and processing of a blockchain graph data structure. FIG. 115 illustrates scoring feature generation and scoring model generation. FIG. 116 illustrates the generation of local trust scores for a blockchain address using a scoring model and scoring features for the blockchain address.

Referring to FIG. 111, the data acquisition and processing module 9700 includes a data acquisition module 9700-1 that acquires data from the fraud and custody data sources 9024. The data acquisition and processing module 9700 also includes a data processing module 9700-2 that processes the acquired data. The raw and processed data 9718 can be stored in the record data store 9710. The data acquisition module 9700-1 can acquire data in a variety of ways. In some implementations, the data acquisition module 9700-1 can acquire curated data, such as curated/purchased data provided by partners/customers. In some cases, data can be user peer-reviewed structured data.

In some implementations, the data acquisition module 9700-1 may be configured to automatically acquire data (e.g., crawl/scrape websites). For example, the data acquisition module 9700-1 may be configured to do targeted data acquisition, such as acquiring data for specific social media accounts. As another example, the data acquisition module 9700-1 may perform more general data acquisition, such as more general crawling/scraping of sites.

The data acquisition module 9700-1 can acquire custody data from custody data sources 9024-1. Custody data may indicate the party that owns/controls the blockchain address (e.g., the keys). Example parties that may take custody of blockchain addresses may include, but are not limited to, exchanges, wallets, and banks. In some implementations, the custody sources 9024-1 can provide the custody data.

In some implementations, the trust module 9200 may implement custodian specific trust score generation. For example, the trust module 9200 may select a specific scoring model based on the custodian associated with the blockchain address. In some implementations, the trust module 9200 may implement customer/custodian specific reporting for blockchain addresses (e.g., based on the custodian associated with the blockchain address). For example, the trust report may be formatted in a specific manner for a specific custodian.

The data acquisition module 9700-1 acquires data that may provide evidence of fraud from a variety of fraud data sources 9024-2. The trust module 9200 may make a determination of the likelihood of fraud for blockchain addresses based on fraud data. For example, the trust module 9200 may label blockchain addresses as fraud based on the fraud data. Subsequently, the trust module 9200 may generate scoring features and scoring models based on the labeled blockchain addresses.

In some implementations, the trust module 9200 may be configured to acquire databases and lists that indicate fraudulent activity associated with a blockchain address. In one example, fraud data sources 9024-2 can include databases of fraud information, such as third-party databases of fraud information and/or customer provided databases of fraud information. The databases may be provided by public entities (e.g., government watchlists) and/or private entities (e.g., a company generated watchlist).

In some examples, a database of fraud information may be provided in the form of a blacklist that includes a list of blockchain addresses that have been identified as having engaged in fraud. In this example, the data acquisition module 9700 may acquire public blacklists, purchase blacklists, and/or receive blacklists from customers. In some cases, blacklists may have been peer reviewed by a community of trusted parties (e.g., experts). In some implementations, the data processing module 9700-2 can mark addresses as fraudulent if the address is included on a blacklist. In other implementations, the presence of the blockchain address on a blacklist can be used as a scoring feature for determining whether the blacklisted blockchain address is likely fraudulent.

In some implementations, the data acquisition module 9700-1 may be configured to acquire fraud data from targeted locations, such as locations on the internet specified by web uniform resource locators (URLs) and/or usernames (e.g., a specific social media account). In some implementations, locations may be provided (e.g., web URLs) that the data acquisition module 9700-1 may monitor for fraudulent activity. For example, a customer may provide a web address to a social media page associated with a specific blockchain address. In this example, the data processing module 9700-2 may identify fraudulent behavior if a blockchain address other than the specified blockchain address appears in the web contents at the web address. In another example, if there is a known contribution address of an initial coin offering (ICO), accounts and blockchain addresses fraudulently attempting to acquire funds (e.g., phish) may be detected. The trust network 9000 may notify a user of the fraudulent address and use the evidence of fraudulent activity as described herein.

Although the data acquisition module 9700-1 may be configured to acquire fraud data from targeted locations, in some implementations, the data acquisition module 9700-1 can generally crawl and scrape other data sources (e.g., social media sites) for fraud data and other data. In these examples, the data processing module 9700-2 may identify fraudulent blockchain addresses based on behavior across a social media platform, such as scams that request funds from multiple social media users, new accounts that directly ask other users for funds, and fake initial coin offering scams.

In some implementations, the trust module 9200 (e.g., the data processing module 9700-2) may label a blockchain address as fraudulent (e.g., at 9720). For example, the data processing module 9700-2 may label a blockchain address as fraud based on fraud data. In a specific example, the data processing module 9700-2 may label a blockchain address as fraud if the blockchain address is included in one or more blacklists. If a blockchain address is not labeled as fraud, the fraud status of the blockchain address may be unknown. Put another way, an unlabeled blockchain address does not necessarily indicate that the blockchain address is not fraudulent. In some cases, a blockchain address may be labeled as a known good address that is not fraudulent. For example, an exchange wallet or verified smart contract may be examples of known good addresses.

For blockchain addresses that are assigned one or more trust scores and labeled as fraud, the fraud label for the blockchain address may be dispositive on the issue of fraud for the blockchain address. As such, in these implementations, the trust module 9200 may disregard the trust score for the blockchain address and/or set the trust score for the blockchain address to a 100% certainty of fraud. In other implementations, the trust module 9200 may continue to calculate trust scores for the blockchain addresses labeled as fraud.

The fraud label 9720 can also include fraud label metadata. The fraud label metadata may indicate the source of the information used to label the blockchain address as fraud (e.g., a specific blacklist). The fraud label metadata may also indicate a type of fraud (e.g., a phishing scam). The fraud label metadata can also include the content of the fraudulent behavior, such as text associated with a scam (e.g., text posted online or in an email). The trust module 9200 can return the fraud label metadata to a requesting device to clearly explain the reason the trust module 9200 has labeled a blockchain address as fraudulent.

Referring to FIG. 112, the blockchain data acquisition module 9702-1 (hereinafter “blockchain acquisition module 9702-1”) can acquire blockchain data from the blockchain network 9018. For example, the blockchain acquisition module 9702-1 can acquire the blockchain transaction ledger 9022. The blockchain acquisition module 9702-1 can store the raw blockchain data 9722 in the record data store 9710. The blockchain processing module 9702-2 can process the blockchain transaction ledger 9022 and store the processed blockchain values 9722 (e.g., transaction amounts, dormancy, etc.) in the record data store 9710 (e.g., in a blockchain address record 9204).

The blockchain transaction ledger 9022 includes data for a plurality of blockchain transactions. Each transaction may include: 1) a sender address, 2) a receiver address, and 3) a value amount (e.g., a coin amount). A transaction may also include transaction identification data that uniquely identifies the transaction on the blockchain. The transaction identification data may be referred to herein as a transaction identifier (ID). In some implementations, a transaction hash can be used as a unique identifier for a transaction. A transaction hash may be a string of pseudorandom characters that uniquely identify a transaction. Some blockchains may also include additional data that may be stored and processed. Example additional data may include internal transaction data, such as a program that is executed in an Ethereum smart contract.

The blockchain transaction ledger can include a plurality of blocks. Each of the blocks can include a collection of transactions. A block may include a collection of transactions that occurred on the blockchain within a certain period of time. A block may include a block number (e.g., a sequentially assigned number) that may act as an identifier for the block. In the case of Bitcoin, a transaction may include the sending party's address, the receiving party's address, the amount sent, and various parameters describing speed. Ethereum may include similar transaction data, as well as raw data around what function on a smart contract was executed, if a function was executed.

Different blockchain networks may include different types of blockchain ledgers. For example, different blockchain ledgers may include blockchain transaction data in different formats. As another example, different blockchain ledgers may include additional or alternative data associated with transactions. The blockchain acquisition module 9702-1 can be configured to acquire blockchain transaction data for different blockchains. For example, the blockchain acquisition module 9702-1 can include different modules, each of which may be configured for acquiring blockchain transaction data for a different blockchain network.

In some cases, a blockchain network can include timing data that indicates the time of blockchain transactions (e.g., relative/absolute time). In these implementations, the blockchain acquisition module 9702-1 can use the provided timing data to indicate when the transaction occurred. In other cases, a blockchain network may not include timing data. In these implementations, the blockchain acquisition module 9702-1 can generate a time stamp for the transaction. In some cases, timing data can be generated from the block assigned to the transaction. Blocks may be assigned as part of the mining process whereby actors on the blockchain compete to verify the validity of a set of transactions. Once a block is mined, and the transactions are verified, then the timing data can be assumed from other miners' consensus.

The blockchain processing module 9702-2 can determine a variety of values based on the acquired blockchain data. The trust module 9200 (e.g., the score generation module 9716) can use the determined values as scoring features for determining trust scores. The trust module 9200 (e.g., the model generation module 9708) can also generate scoring models based on the determined values. The blockchain values for a blockchain address can be stored in the blockchain address record (e.g., at 9722).

The blockchain processing module 9702-2 can include functionality for determining the different blockchain values described herein. For example, the blockchain processing module 9702-2 of FIG. 112 includes a dormancy determination module 9750 that can determine dormancy values for a blockchain address. The blockchain processing module 9702-2 also includes a behavior identification module 9752 that can determine whether the blockchain address matches one or more behavioral templates (e.g., patterns or fingerprints). The modules 9750, 9752 included in the blockchain processing module 9702-2 of FIG. 112 are only example modules. As such, the blockchain processing module 9702-2 may include additional/alternative modules than those modules illustrated in FIG. 112. Additionally, the blockchain values included in the blockchain data 9722 of FIG. 112 are only example values. As such, the blockchain data for a blockchain address may include additional/alternative values.

In some implementations, the blockchain processing module 9702-2 may determine values associated with the amount of funds transacted by a blockchain address. For example, the blockchain processing module 9702-2 may determine: 1) a total amount of funds received by the blockchain address, 2) a total amount of funds sent by the blockchain address, 3) the total amount of funds transacted in and out of the blockchain address, and 4) the average transaction amount for the blockchain address.

In some implementations, the blockchain processing module 9702-2 may determine values associated with the timing of transactions associated with a blockchain address. For example, the blockchain processing module 9702-2 can determine an activity level of the blockchain address, such as how often the address is involved in a transaction (e.g., average times between transactions and variance). As another example, the blockchain processing module 9702-2 can determine the age of transactions associated with the address. Another example scoring feature related to timing may include the time between entrance of funds and exit of funds from a blockchain address (e.g., timing for a single transaction or average over multiple transactions). In some cases, fraudulent activity may not immediately exit an address.

As another example, the dormancy determination module 9750 can determine the probability of dormancy for the blockchain address. An example dormancy probability may indicate an amount of time for which the blockchain address is not associated with transactions. For example, a dormancy probability may indicate an amount of time for which the blockchain address is not associated with transactions relative to the address' expected time between transactions. Put another way, the example dormancy time may indicate the probability that the blockchain address is dormant. With respect to dormancy likelihood, fraudulent addresses may not stay active for long in some cases.

In some implementations, the blockchain processing module 9702-2 may determine values associated with the timing of transactions and the amount of the transactions. For example, the blockchain processing module 9702-2 may determine: 1) a total amount of funds received over a period of time, 2) a total amount of funds transferred over a period of time, and 3) a total amount of funds transacted over a period of time.

In some implementations, the blockchain processing module 9702-2 may determine values associated with how the blockchain address interacts with other blockchain addresses. For example, the blockchain processing module 9702-2 may determine the list of addresses that have interacted with the blockchain address and/or the total number of addresses that have interacted with the blockchain address (e.g., as senders and/or receivers). This value may be iteratively computed to determine how important an address is to its local neighborhood and the blockchain as a whole.

The blockchain processing module 9702-2 includes a behavior identification module 9752 that can determine whether a blockchain address matches specific behavior templates that may be indicative of fraud. If the behavior identification module 9752 identifies a match between a blockchain address' behavior and a behavior template, the match may be stored in the blockchain address record 9204. In some implementations, the local trust data store 9202 may store a set of behavior templates. In these implementations, the behavior identification module 9752 can determine whether the blockchain address' behavior matches one or more of the set of behavior templates.

A behavior template may include a set of conditions that, if satisfied, cause the behavior template to be matched to the blockchain address. A behavior template may include conditions that are based on any of the blockchain values described herein. For example, a behavior template may include conditions that are based on at least one of 1) amounts of funds transferred, 2) the number of transactions, 3) the timing of transactions (e.g., rate of transactions), 4) how the blockchain address interacts with other addresses (e.g., number of different senders/receivers and patterns of transactions), and 5) the likelihood of dormancy of the address.

In one specific example, a behavior template may define a threshold number of transactions (e.g., 5 transactions in and out) at a threshold rate. In this example, the behavior template may be matched if a blockchain address engages in a low number of transactions (e.g., less than or equal to the threshold number) in quick succession (e.g., a short rapid burst). Another example condition for the behavior template may be a high dormancy probability, as any transactions may be limited to bursts. In another specific example, a behavior template may define a high threshold number of transactions (e.g., irregularly high for the blockchain). In this example, a behavior template may be matched if the blockchain address engages in greater than the threshold number of transactions. In this example, the behavior template may also require a high importance value, such that the blockchain address is required to have a minimum importance value to match the template. Furthermore, the behavior template may require a low likelihood of dormancy, as the fraudulent behavior may follow a pattern of regular transactions.

If the blockchain address matches a behavior template, the match may be stored as a blockchain value in the blockchain address record 9204. For example, the blockchain address record may store a binary value (e.g., 0/1) for each behavior template that indicates whether the behavior template was matched. In implementations where the behavior identification module 9752 determines a value (e.g., a decimal or integer value) that indicates how well the blockchain address matches the behavior template, the value may be stored in the blockchain address record 9204.

Referring to FIG. 113 and FIG. 114, the graph generation module 9704-1 generates a blockchain graph data structure based on the blockchain transactions for a plurality of different blockchain addresses. The graph data structure includes blockchain addresses and transactions between the blockchain addresses. For example, for each blockchain address, the graph data structure may describe each transaction associated with the blockchain address along with the direction of the transaction, such as whether the blockchain address was a sender or receiver. The graph data structure can also include the transaction amount for each transaction. In some implementations, the graph data structure can include fraud data (e.g., fraud labels). The fraud label can indicate that the address has been involved in fraudulent activity (e.g., a known fraudulent address).

FIG. 114 illustrates an example representation of the graph data structure. In FIG. 114, the graph data structure is represented by nodes and edges. The graph data structure includes blockchain addresses as nodes of the graph. The transactions between blockchain addresses are edges between the nodes, where the arrows indicate the direction of the transaction (e.g., the receiver is at the arrowhead). The amount for each transaction is labeled adjacent to the arrow. The fraud label for each blockchain address is included above the node. FIG. 114 includes 4 transactors with blockchain addresses A, X, Y, Z. Blockchain address Y has been labeled as a fraudulent address. The other blockchain addresses have an unknown fraud status. The graph illustrates 3 blockchain transactions. A first transaction is from blockchain address X to blockchain address A for a first amount (i.e., amount 1). A second transaction is from blockchain address Y to blockchain address A for a second amount (i.e., amount 2). A third transaction is from blockchain address A to blockchain address Z for a third amount (i.e., amount 3).

The graph data structure is stored in the graph data store 9712. The graph generation module 9704-1 can update the graph data structure over time so that the graph data structure includes an up to date representation of the transactions included on the blockchain network 9018.

The graph processing module 9704-2 can generate graph-based values 9724 using the graph data structure. The graph-based values 9724 may be stored in the blockchain address record 9204. The graph processing module 9704-2 can update the graph-based values 9724 over time.

In some implementations, the graph processing module 9704-2 can determine one or more importance values for each of the blockchain addresses. The importance values may indicate the importance of a blockchain address relative to other blockchain addresses (e.g., relative to all blockchain addresses). In some implementations, the graph processing module 9704-2 may determine the importance values for a blockchain address based on adjacent blockchain addresses. In some implementations, the graph processing module 9704-2 may weight the contribution of adjacent blockchain addresses by the importance of the blockchain addresses.

In some implementations, the graph processing module 9704-2 may determine an importance value by counting the number of transactions coming into a blockchain address. In this specific example, more transactions may indicate that the blockchain address is more important than other blockchain addresses with fewer incoming transactions. In some implementations, the graph processing module 9704-2 may determine an importance value by determining the number of different blockchain addresses with which the blockchain interacts. In some implementations, the graph processing module 9704-2 may determine an importance value that indicates the total amount of funds into the blockchain address relative to the amount of funds out of the address (e.g., amount out divided by amount in). In another example, the graph processing module 9704-2 may determine an importance value that indicates the number of transactions into the blockchain address relative to the number of transactions out of the blockchain address (e.g., total number of transactions in divided by total number of transactions out). In another example, the graph processing module 9704-2 may determine an importance value based on the number of transactions in to the blockchain address, the number of transactions out of the blockchain address, the amount of funds in, and the amount of funds out. In some implementations, the graph processing module 9704-2 may implement other processing techniques, such as PageRank (PR) and/or personalized hitting time (PHT).

In some implementations, the graph processing module 9704-2 may determine a fraud distance scoring feature that indicates the blockchain address' distance from fraud in the graph. For example, fraud distance scoring features may include a minimum distance from fraud, an average distance from fraud, and/or the number of fraudulent blockchain addresses with which the blockchain address has interacted.

Referring to FIG. 115, the feature generation module 9706 can generate scoring features for each of the blockchain addresses. The trust module 9200 (e.g., score generation module 9716) can generate one or more local trust scores for a blockchain address based on the scoring features associated with the blockchain address. The scoring features can be numerical values (e.g., integer or decimal values), Boolean values (e.g., 0/1), enumerated values, or other values.

The feature generation module 9706 can generate the scoring features based on any of the blockchain values described herein. For example, scoring features for a blockchain address may be based on 1) amounts associated with transactions, 2) timing data associated with transactions (e.g., dormancy), 3) graph-based values (e.g., one or more importance values) associated with the blockchain address, and/or 4) behavior-based data associated with the blockchain address.

With respect to behavior-based data, the feature generation module 9706 may generate a Boolean scoring feature that indicates whether the blockchain address matches any of the behavior templates. In another example, the feature generation module 9706 may generate a Boolean scoring feature for each of the behavior templates, such that the scoring features identify which of the behavior templates are matched. In another example, the feature generation module 9706 may generate a scoring feature that indicates how many of the behavior templates were matched (e.g., a percentage of the total available). In another example, instead of generating Boolean features, the feature generation module 9706 may generate numeric values that indicate how well the blockchain address matched the behavior templates, such as a decimal value (e.g., 0.00-1.00) that indicates how well the behavior template was matched.

The trust module 9200 includes a scoring model generation module 9708 (referred to herein as a “model generation module 9708”) that can generate scoring models that are used to generate local trust scores for a blockchain address. For example, a scoring model can receive scoring features for a blockchain address and output a local trust score for the blockchain address. The model generation module 9708 can generate a scoring model based on training data. The training data can include scoring features along with associated fraud labels. The set of scoring features a model uses as input may be referred to herein as a “feature vector.” In some implementations, the trust module 9200 can use a deep neural net to score, where the classification is determined by known good/bad addresses. The neural net may be trained over the feature vectors. In some implementations, the trust module 9200 can leverage models based on random forests, decision trees, and logistic regression, and combine them in the form of a “consensus of experts.”

The model generation module 9708 can generate a scoring model (e.g., a machine learned model) based on training data that includes sets of feature vectors and their corresponding fraud label (e.g., Fraud: 0/1). In this example, the generated scoring model may output a local trust score (e.g., a decimal value) that indicates the likelihood the blockchain address is fraudulent. In some implementations, the training data may also include a label that positively indicates that the blockchain address is a known good address (e.g., not fraudulent).

Although the trust module 9200 can generate scoring models that are used to generate local trust scores, the trust module 9200 may generate local trust scores in other manners. For example, the trust module 9200 may generate local trust scores using scoring functions (e.g., weighted scoring functions) and/or heuristic models that generate local trust scores according to rules.

FIG. 116 illustrates an example score generation module 9716 that generates local trust scores for blockchain addresses. The score generation module 9716 may generate a local trust score for a blockchain address by using a feature vector for the blockchain address and a scoring model. For example, the score generation module 9716 may input a feature vector for a blockchain address into a scoring model that outputs a local trust score.

The local trust score 9208 for a blockchain address can be stored in the blockchain address record 9204. The score generation module 9716 can generate local trust scores for each of the blockchain addresses. The score generation module 9716 can also update the local trust scores over time, such as when additional data is acquired. A blockchain address record 9204 can include the most recently calculated local trust score, as well as historically calculated local trust scores. In some implementations, the trust module 9200 can leverage the change in local trust score (and historical score) to provide a real-time alerting system, such that a party can be notified if the trust score of an address drops (e.g., as in the case of an organization receiving fraudulent funds through an address they control). The trust module 9200 may provide an API that can hook into their service that can freeze the transaction and alert the relevant people at that organization (e.g., by phone, email, etc.).

The score generation module 9716 may be configured to provide the local trust score in a variety of formats. In some implementations, the local trust score may be an integer value with a minimum and maximum value. For example, the local trust score may range from 1-7, where a trust score of ‘1’ indicates that the blockchain address is likely fraudulent. In this example, a trust score of ‘7’ may indicate that the blockchain address is not likely fraudulent (i.e., very trustworthy). In some implementations, the local trust score may be a decimal value. For example, the local trust score may be a decimal value that indicates a likelihood of fraud (e.g., a percentage value from 0-100%). In some implementations, a local trust score may range from a maximum negative value to a maximum positive value (e.g., −1.00 to 1.00), where a larger negative value indicates that the address is more likely fraudulent. In this example, a larger positive value may indicate that the address is more likely trustworthy. The customer may select the trust score format they prefer.

In some implementations, the blockchain address record 9204 can store request data 9728 for each trust request. The request data 9728 may include any data associated with a received trust request and/or the provided trust response. The request data 9728 may be stored in the associated blockchain address record 9204. In some implementations, a blockchain address record may store request data 9728 each time a trust request is made for the blockchain address. In these implementations, the request data 9728 may indicate a number of times a trust request was made for the blockchain address. The request data 9728 may also indicate the blockchain address that made the trust request, the consensus trust score that was reported to the requestor, and the time of the request. Accordingly, the request data 9728 may show trends over time regarding the parties that are requesting trust scores for a blockchain address. In some implementations, the scoring features for a blockchain address may include scoring features that are based on the request data 9728. One example scoring feature may be a total number of times a trust request was made for the blockchain address. Another example scoring feature may be a number of different blockchain addresses that made trust requests for the blockchain address. Other example features may include the frequency at which trust requests were made for the blockchain address (e.g., a number of requests over a time period).

Although the trust module 9200 may calculate a single local trust score for each of the blockchain addresses, regardless of whether the blockchain address is a sender or receiver, in some implementations, the trust module 9200 may calculate a receiver trust score and a sender trust score for each address. In one example, a blockchain address which regularly falls prey to scams can have the sender trust score set as less trustworthy than a blockchain address which does not often fall prey to scams. In another example, a blockchain address which regularly falls prey to phishing scams may not have a modified receiver trust score when there is no indication of nefarious activity associated with receiving funds at the blockchain address.

FIGS. 117-125 are directed to an environment in which a cryptocurrency blockchain network 9770 can execute smart contracts provided by a trust network 9772-1 (e.g., including trust nodes 9772-1a, 9772-1b, . . . , 9772-1N) or a centralized trust system 9772-2 (e.g., see FIG. 117 and FIG. 120). For example, the blockchain network 9770 may provide a virtual machine 9774 (VM) (e.g., a decentralized virtual machine) that executes the smart contracts. The smart contracts described herein can include a variety of functionality. For example, a smart contract may request a trust score for a potential receiver address from the trust network/system 9772 and then complete or cancel a blockchain transaction based on the trustworthiness of the receiver address. Using smart contracts according to FIGS. 117-125 provides for the acquisition of trust scores using the native cryptocurrency of the blockchain network 9770 (e.g., cryptocurrency blockchain tokens) instead of using UTOKEN.

FIG. 117 illustrates an environment that includes a cryptocurrency blockchain network 9770 that executes smart contracts. The cryptocurrency blockchain network 9770 may receive the smart contracts from a variety of sources, such as a decentralized trust network 9772-1 or a centralized trust system 9772-2 (hereinafter “trust system 9772-2”). The blockchain network 9770 includes cryptocurrency blockchain protocols 9776 and a cryptocurrency blockchain ledger 9778, as described with respect to FIG. 90. The cryptocurrency blockchain protocols 9776 of FIG. 117 may create virtual machines 9774 (e.g., process virtual machines) that execute the smart contracts 9780. For example, the virtual machines 9774 may execute the smart contracts 9780 on one or more nodes of the blockchain network 9770. An example virtual machine on a blockchain network is the Ethereum Virtual Machine that operates on the Ethereum blockchain.

The distributed trust network 9772-1 of FIG. 117 may provide similar functionality as the trust network 9000 of FIG. 90 described herein. The trust network 9772-1 may also provide functionality associated with the smart contracts. For example, the trust network 9772-1 may provide smart contracts for execution on the blockchain network 9770. In some implementations, the trust network 9772-1 may include smart contract templates 9810 (e.g., see FIG. 120) that may be provided to parties (e.g., exchanges/wallets) for execution on the blockchain network 9770. In some implementations, the trust network 9772-1 may also provide an interface (e.g., an API) for completing smart contract templates with data, such as a sender address, a receiver address, and a specified trust level for transactions. The trust network 9772-1 can also be configured to provide trust scores to smart contracts that are instantiated on the blockchain network 9770. A smart contract may complete or cancel a transaction based on the received trust score.

In some implementations, a party (e.g., a company) may operate a trust system 9772-2 that provides functionality associated with the smart contracts described herein. In some implementations, the same party (e.g., company) can operate one or more nodes on the trust network 9772-1 and also operate a trust system 9772-2. For example, the party may provide different trust nodes/systems for different business partners/customers. In other implementations, different parties (e.g., companies) may operate trust network nodes and one or more trust systems. Furthermore, different trust systems/networks may be implemented for different cryptocurrency blockchain networks.

The trust system 9772-2 can provide similar functionality as the trust network 9772-1. The trust system 9772-2 (e.g., a server) generates trust scores for cryptocurrency transactors (e.g., user devices 9002, intermediate systems 9004, and automated transaction systems 9006). For example, the trust system 9772-2 can generate trust scores for different blockchain addresses that interact on the blockchain network 9770. The trust system 9772-2 may determine the trust scores based on data retrieved from various data sources along with blockchain data upon which the cryptocurrency is based. For example, the trust system 9772-2 can determine trust scores for blockchain transactions in a similar manner as described with respect to the trust node 9000-1. A cryptocurrency transactor can request trust scores from the trust system 9772-2 before engaging in a blockchain transaction in which funds (e.g., blockchain tokens) are transacted on the blockchain.

FIG. 120 illustrates an example trust system 9772-2 that can determine trust scores for blockchain addresses. The trust system 9772-2 of FIG. 120 includes modules that perform similar functions as described with respect to the trust node 9000-1. The detailed example trust system 9772-2 of FIG. 120 is only an example trust system. As such, a trust system may include additional/alternative functionality than that illustrated in FIG. 120.

The data acquisition and processing module 9812 acquires and processes a variety of types of data, such as custody data and fraud data, which may be stored in the trust system data store 9811. The data acquisition and processing module 9812 may also generate a fraud label that indicates whether the blockchain address is likely fraudulent based on the acquired fraud data. The blockchain acquisition and processing module 9814 acquires and processes blockchain data that may be stored in the trust system data store 9811. The trust system data store 9811 may also include a plurality blockchain address records. The graph generation and processing module 9816 generates a blockchain graph data structure based on the blockchain data. The graph generation data structure may be stored in the graph data store 9813. The graph generation and processing module 9816 may also process the graph to determine one or more graph-based values (e.g., importance values) that may be used to generate trust scores. The feature generation module 9818 generates scoring features for blockchain addresses. The scoring model generation module 9820 generates one or more scoring models based on the scoring features and other data (e.g., labeled fraud data). The scoring models may be stored in the scoring model data store 9815. The trust score generation module 9822 generates one or more trust scores for blockchain addresses using one or more scoring models and the scoring features associated with the blockchain addresses.

The trust system 9772-2 includes a transactor interface module 9824 that receives a trust request for a blockchain address from a requesting device. The trust request may refer to a request other than a contract trust request. The transactor interface module 9824 sends a trust response including a trust score to the requesting device.

As described with respect to the trust network 9772-1, the trust system 9772-2 can also provide smart contract templates 9810 and completed smart contracts to requesting parties for execution on the blockchain network 9770. Additionally, the trust system 9772-2 can also be configured to provide trust scores to smart contracts instantiated on the blockchain network 9770.

FIG. 118 illustrates a method that describes operation of the environment of FIG. 117. FIG. 119 is a functional block diagram that illustrates interactions between a sender user device 9002, an intermediate transaction system 9004 (e.g., an exchange or centralized wallet system) (hereinafter “intermediate system 9004”), the blockchain network 9770, and the trust network/system 9772 according to FIG. 118. FIGS. 120-121 illustrate an example trust system 9772-2 and trust node 9772-1a that implement functionality associated with the smart contracts. For example, FIGS. 120-121 illustrate contract distribution modules 9830-1, 9830-2, contract template data stores 9832-1, 9832-2, and contract interface modules 9834-1, 9834-2 that implement functionality associated with smart contracts.

The method of FIG. 118 is now described with respect to FIGS. 119-123. In block 9790, a smart contract template 9810 is provided by the trust network/system 9772 for completion and distribution. The contract distribution modules 9830 and contract template data stores 9832 provide the smart contract completion and distribution functionality for the trust system 9772-2 and trust node 9772-1a. The contract template data stores 9832 store smart contract templates. The contract distribution modules 9830 provide an interface (e.g., an API) that a party (e.g., an exchange) can use to modify/complete the smart contract template 9810 and acquire the completed smart contract for instantiation on the blockchain network 9770. In the trust network 9772-1, smart contract template storage, smart contract generation, and smart contract distribution may be decentralized across the plurality of trust nodes. The trust node 9772-1a of FIG. 121 is an example trust node. As such, trust nodes may include additional and/or alternative functionality (e.g., see FIG. 100).

Referring to FIG. 120, a smart contract template 9810 can include smart contract code 9840 that executes on the blockchain network 9770. The smart contract code 9840 may include computer-readable instructions that may be executed by one or more processing units. Smart contracts may be written in one or more languages and compiled into bytecode that is deployed on the blockchain network 9770 for execution. With respect to the Ethereum blockchain, a smart contract can be written in one or more programming languages (e.g., Solidity) and compiled into Ethereum Virtual Machine bytecode for deployment on the Ethereum blockchain. The smart contract code can be executed on the blockchain network 9770 to implement the functionality attributed to the smart contracts herein. For example, the smart contract code 9840 can include a series of rules (e.g., business rules) that are run on the blockchain network 9770. Example functionality executed by the smart contract code 9840 may include, but is not limited to: 1) generating a contract trust request, 2) receiving a trust score, 3) determining whether the trust score indicates a receiver is trustworthy, and 4) completing/canceling a transaction based on the trust score. Since the smart contracts may be implemented on a blockchain network, the smart contracts may also be referred to as “blockchain smart contracts” or “decentralized blockchain-based smart contracts.”

A smart contract template 9840 may include fields for receiving values that can complete the smart contract template 9840. The intermediate system 9004 (e.g., an exchange) can provide the values for completing the fields in the smart contract. Example smart contract fields may include, but are not limited to: 1) a contract trust threshold field 9842, 2) a sender address field 9844, 3) a receiver address field 9846, 4) a transaction amount field 9848, 5) a trust fee field 9840, and 6) a trust fee payment address 9842. A sender transactor can provide some/all of the values for completing the smart contract to the intermediate system 9004 (e.g., see FIG. 122). The contract distribution modules 9830 can complete the smart contract templates according to the values received from the intermediate system 9004. The intermediate system 9004 can instantiate the completed smart contract on the blockchain network 9770.

In block 9792, the sender transactor is provided with an interface for arranging a transaction with a receiver address. For example, the intermediate system 9004 (e.g., an exchange) can provide a user interface (e.g., a GUI) for the sender transactor to set up a trust-protected transaction with a receiver. The interface can receive a sender's inputs for setting up and completing the transaction. For example, the interface can include GUI elements for receiving one or more addresses, coin amounts, and a specified contract trust threshold. In some implementations, the trust system/node administrator can work with parties (e.g., exchanges/wallets) to build an interface (e.g., an exchange/wallet interface).

FIGS. 122-123 illustrate an example sender interface on a user device 9002. The sender interface allows the sender to specify a transaction amount (e.g., 5 coins) to send to a receiver address. In FIG. 122, the GUI includes GUI elements that the sender can use to select whether to use trust protection. The example GUI elements are radio buttons that provide the user with a yes/no selection. If a trust-protected transaction is selected, there is a GUI element that can receive a user-specified level of trust for the transaction. For example, the sender may select the low, medium, or high GUI buttons to select a low, medium, or high risk level for the transaction. In FIG. 122, the user has selected the medium level of trust, as indicated by the darkened “Med.” GUI element. The selectable risk levels may correspond to contract trust threshold values. For example, the low risk level may require a higher trust score (e.g., a greater trustworthiness) for completion of the transaction than the medium and high risk levels. In some implementations, the intermediate system 9004 may include a preset contract trust threshold (e.g., set by an exchange) instead of providing the user with a GUI element for selecting the risk level. In some implementations, the smart contract template 9810 may include a preset contract trust threshold.

The GUI of FIG. 122 provides a summary of the total amount for the trust-protected transaction. For example, the GUI indicates the trust fee and the network fee for the trust report and the contract execution, respectively. The GUI includes a “Send Coins” button GUI element that the user can select to begin the transaction according to the smart contract. FIG. 123 illustrates an example GUI provided by the intermediate system 9004 that indicates the transaction was completed. The GUIs illustrate in FIGS. 122-123 may be provided by the intermediate system 9004 (e.g., via a web-based interface) and/or an application installed on the user device 9002.

In block 9794, the smart contract is generated according to the sender's input and instantiated on the blockchain network 9770. For example, the intermediate system 9004 can send the values entered into the sender interface (e.g., see FIG. 122) to the contract distribution modules 9830. The contract distribution modules 9830 can generate a completed contract using the received values and a smart contract template 9810. The contract distribution modules 9830 can send the completed contract to the intermediate system 9004. The intermediate system 9004 can then instantiate the smart contract on the blockchain network 9770.

The intermediate system 9004 may instantiate the smart contract with different completed fields. For example, the intermediate system 9004 can instantiate the smart contract with a specified contract trust threshold in some implementations. In another example, the intermediate system 9004 can instantiate the smart contract without a specified contract trust threshold. In this example, the contract trust threshold value may be sent to the contract (e.g., by the intermediate system 9004) after the smart contract is instantiated on the blockchain network 9770. In a similar manner, the intermediate system 9004 may include any values described herein in the instantiated smart contract or may provide any of the values after instantiation of the smart contract. The number of defined values included in the smart contract can vary based on the implementation chosen by the operators of the intermediate system 9004 and/or the capabilities of the blockchain network 9770. It can be assumed hereinafter that a completed smart contract includes values for the contract trust threshold, sender address, receiver address, transaction amount, trust fee, and trust fee payment address.

Other smart contract implementations may vary based on decisions made by the operator of the intermediate system 9004 and/or the capabilities of the blockchain network 9770. For example, instead of retrieving a new smart contract for each transaction and completing the smart contract, in some cases, a smart contract may remain on the blockchain network and run subsequent transactions based on newly received values (e.g., new receiver addresses and transaction amounts). In some cases, an intermediate system may retrieve a single version of the smart contract from the trust network/system and modify it for multiple transactions.

In some implementations, the sender pays a network fee in order to instantiate a smart contract on the blockchain network 9770. In these implementations, the network fee may be paid from the sender address to instantiate the smart contract. The blockchain network 9770 may begin execution of the smart contract after payment of the network fee. The network fee may be referred to as “gas” in some cases. In some implementations, the network fee may be set by the blockchain network 9770. Over time, the blockchain network 9770 may modify the network fee. Although a sender address may pay the network fee for instantiation and execution of the smart contract, in some implementations, the network fee may be paid for by an existing intermediate system address.

The instantiated smart contract 9780 is associated with a smart contract address on the blockchain network 9770. The sender funds (e.g., transaction amount and trust fee amount) may be transferred to the contract blockchain address when the smart contract is instantiated. The smart contract 9780 can hold the funds and distribute the funds according to the smart contract 9780 described herein. The intermediate system 9004 may send the instantiated contract address to the trust network/system 9772. The trust network/system 9772 can monitor the instantiated contract address to verify trust fee payments and monitor the blockchain ledger 9778 for a contract trust request.

As described herein, the trust network/system 9772 may receive trust fee payments for providing trust reports. With respect to trust reports provided to the smart contract 9780, the trust network/system 9772 may receive payments at a trust fee payment address on the blockchain network 9770. The trust fee payment address may be controlled by the trust network/system 9772. The contract address may pay the trust fee using the blockchain's native tokens, referred to herein as cryptocurrency blockchain tokens. In some implementations, the trust network/system 9772 can include one or more blockchain addresses for receiving trust fee payments. The trust network/system 9772 can acquire one or more trust fee payments from the trust fee payment address. For the trust system 9772-2, the trust fee may be set/modified by the operator of the trust system 9772-2. For the trust network 9772-1, the reward protocol can set/modify the trust fee.

In block 9796, the smart contract 9780 acquires a trust score from the trust network/system 9772. To acquire a trust score, the smart contract 9780 may generate a contract trust request for the receiver address. The contract trust request may be a request for a trust report for the receiver address (e.g., one or more trust scores for the receiver address). The smart contract 9780 can generate the contract trust request in a variety of ways. In some implementations, the smart contract 9780 can write the contract trust request to a ledger (e.g., the blockchain ledger 9778) under the contract address. The contract trust request can include a code written to the ledger 9778 that identifies the ledger entry as a contract trust request for the trust network/system 9772. Additionally, the contract trust request may indicate the receiver address for which the trust report is requested. Although the smart contract 9780 may write the trust request to the ledger 9778, in some implementations, the smart contract 9780 may be configured to send requests to the trust network/system 9772 (e.g., via an API) if the blockchain network 9770 supports the functionality.

The trust network/system 9772 (e.g., the contract interface modules 9834) may be configured to scan the blockchain ledger 9778 to identify contract trust requests made by smart contracts 9780. In implementations where the contract address is reported to the trust network/system 9772 (e.g., by the intermediate system 9004), the trust network/system 9772 may be configured to scan the reported contract addresses for contract trust requests.

In some implementations, prior to providing the trust score to the smart contract 9780, the trust network/system 9772 determines whether the trust fee has been paid. The trust network/system 9772 (e.g., the contract interface modules 9834) can scan the blockchain ledger 9778 to determine whether the trust fee has been paid. For example, the trust network/system 9772 may determine that the trust fee has been paid by identifying a transaction between the contract address and the trust fee payment address for the trust fee amount.

After identification of the contract trust request and verification of the trust fee payment, the trust network/system 9772 (e.g., the contract interface modules 9834) may identify/calculate the trust score(s) for the receiving address indicated in the contract trust request. The trust network/system 9772 may then send the trust score to the smart contract 9780. Inputting data into a smart contract may vary based on the blockchain network. For example, on the Ethereum network, data may be input into the smart contract according to the Ethereum Request for Comments (ERC) technical standard.

In block 9798, the smart contract 9780 determines whether the receiver is trustworthy based on the received trust score. In some implementations, the smart contract 9780 may compare the received trust score to the contract trust threshold to determine whether the receiver is trustworthy. For example, where a larger trust score indicates a more trustworthy address, the smart contract 9780 may determine that the receiver address is trustworthy when the received trust score is greater than the contract trust threshold. In this example, the smart contract 9780 may determine that the receiver address is not sufficiently trustworthy when the received trust score is less than the contract trust threshold. In a specific example, where the trust score is a decimal value that indicates a likelihood of fraud (e.g., a percentage value from 0-100%), an example contract trust threshold may be set to 0.35 (i.e., 35%). As described herein, in some implementations, a trust score may range from a maximum negative value to a maximum positive value (e.g., −1.00 to 1.00), where a larger negative value indicates that the address is more likely fraudulent. In this specific example, a contract trust threshold may be set somewhere in the range of −1.00 to 1.00.

If the smart contract 9780 determines that the receiver address is trustworthy in block 9798, the smart contract 9780 sends the transaction amount to the receiver address in block 9800. If the smart contract 9780 determines that the receiver address is not trustworthy in block 9798, the smart contract 9780 sends the transaction amount back to the sender address in block 9802.

In block 9804, a transaction report is sent to the sender that summarizes the transaction. For example, the intermediate system 9004 may read transaction data from the blockchain network 9770, such as whether the transaction was completed/canceled and the amount of token sent in the transaction. The intermediate system 9004 may then generate a transaction report for the sender user device 9002. An example transaction report is illustrated in FIG. 123. The transaction report of FIG. 123 indicates that the transaction was completed because the receiver address was sufficiently trustworthy.

FIG. 124 illustrates an example method describing operation of the intermediate system 9004 of FIG. 117. In block 9850, the intermediate system 9004 generates an interface (e.g., a web-based GUI) for the sender user device 9002. In block 9852, the intermediate system 9004 receives contract values from the sender user device 9002, such as values inserted into the interface. In block 9854, the intermediate system 9004 retrieves a smart contract that was completed by the trust network/system 9772 based on the contract values.

In block 9856, the intermediate system 9004 instantiates the completed smart contract on the blockchain network 9770. In block 9858, the intermediate system 9004 reports the smart contract address to the trust network/system 9772. In block 9860, the intermediate system 9004 generates a transaction report for the sender based on the completion/cancellation of the transaction associated with the instantiated smart contract.

FIG. 125 illustrates an example method describing operation of the trust network/system 9772 of FIG. 117. In block 9880, the trust network/system 9772 receives contract values for a smart contract template from the intermediate system 9004. In block 9882, the trust network/system 9772 generates a completed smart contract based on the received contract values. In block 9884, the trust network/system 9772 sends the completed smart contract to the intermediate system 9004.

In block 9886, the trust network/system 9772 receives a contract address from the intermediate system 9004 for the instantiated smart contract. In block 9888, the trust network/system 9772 monitors the blockchain ledger 9778 for a trust fee payment. In block 9890, the trust network/system 9772 monitors the blockchain ledger 9778 for a contract trust request associated with the contract address. In block 9892, the trust network/system 9772 sends a trust score for the receiver address to the smart contract.

Modules and data stores included in the trust networks/systems represent features that may be included in the trust networks/systems of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component (e.g., main memory and/or a storage device) may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the data included in the data stores. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provide communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the trust networks/systems may include one or more computing devices (e.g., node computing/server devices) that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the trust networks/systems may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices may reside within a single machine at a single geographic location in some examples. In other examples, the one or more computing devices may reside within multiple machines at a single geographic location. In still other examples, the one or more computing devices of the trust networks/systems may be distributed across a number of geographic locations.

### Dual Process Artificial Neural Network

In embodiments, the platform 100 includes a dual process artificial neural network (DPANN) system 12600. The DPANN system 12600 includes an artificial neural network (ANN) having behaviors and operational processes (such as decision-making) that are products of a training system and a retraining system. The training system is configured to perform automatic, trained execution of ANN operations. The retraining system performs effortful, analytical, intentional retraining of the ANN, such as based on one or more relevant aspects of the ANN, such as memory, one or more input data sets (including time information with respect to elements in such data sets), one or more goals or objectives (including ones that may vary dynamically, such as periodically and/or based on contextual changes, such as ones relating to the usage context of the ANN), and/or others. In cases involving memory-based retraining, the memory may include original/historical training data and refined training data. The DPANN system 12600 includes a dual process learning function (DPLF) configured to manage and perform an ongoing data retention process. The DPLF (including, where applicable, memory management process) facilitate retraining and refining of behavior of the ANN. The DPLF provides a framework by which the ANN creates outputs such as predictions, classifications, recommendations, conclusions and/or other outputs based on a historic inputs, new inputs, and new outputs (including outputs configured for specific use cases, including ones determined by parameters of the context of utilization (which may include performance parameters such as latency parameters, accuracy parameters, consistency parameters, bandwidth utilization parameters, processing capacity utilization parameters, prioritization parameters, energy utilization parameters, and many others).

In embodiments, the DPANN system 12600 stores training data, thereby allowing for constant retraining based on results of decisions, predictions, and/or other operations of the ANN, as well as allowing for analysis of training data upon the outputs of the ANN. The management of entities stored in the memory allows the construction and execution of new models, such as ones that may be processed, executed or otherwise performed by or under management of the training system. The DPANN system 12600 uses instances of the memory to validate actions (e.g., in a manner similar to the thinking of a biological neural network (including retrospective or self-reflective thinking about whether actions that were undertaken under a given situation where optimal) and perform training of the ANN, including training that intentionally feeds the ANN with appropriate sets of memories (i.e., ones that produce favorable outcomes given the performance requirements for the ANN).

In embodiments, the DPLF may be or include the continued process retention of one or more training datasets and/or memories stored in the memory over time. The DPLF thereby allows the ANN to apply existing neural functions and draw upon sets of past events (including ones that are intentionally varied and/or curated for distinct purposes), such as to frame understanding of and behavior within present, recent, and/or new scenarios, including in simulations, during training processes, and in fully operational deployments of the ANN. The DPLF may provide the ANN with a framework by which the ANN may analyze, evaluate, and/or manage data, such as data related to the past, present and future. As such, the DPLF plays a crucial role in training and retraining the ANN via the training system and the retraining system.

In embodiments, the DPLF is configured to perform a dual-process operation to manage existing training processes and is also configured to manage and/or perform new training processes, i.e., retraining processes. In embodiments, each instance of the ANN is trained via the training system and configured to be retrained via the retraining system. The ANN encodes training and/or retraining datasets, stores the datasets, and retrieves the datasets during both training via the training system and retraining via the retraining system. The DPANN system 12600 may recognize whether a dataset (the term dataset in this context optionally including various subsets, supersets, combinations, permutations, elements, metadata, augmentations, or the like, relative to a base dataset used for training or retraining), storage activity, processing operation and/or output, has characteristics that natively favor the training system versus the retraining system based on its respective inputs, processing (e.g., based on its structure, type, models, operations, execution environment, resource utilization, or the like) and/or outcomes (including outcome types, performance requirements (including contextual or dynamic requirements), and the like. For example, the DPANN system 12600 may determine that poor performance of the training system on a classification task may indicate a novel problem for which the training of the ANN was not adequate (e.g., in type of data set, nature of input models and/or feedback, quantity of training data, quality of tagging or labeling, quality of supervision, or the like), for which the processing operations of the ANN are not well-suited (e.g., where they are prone to known vulnerabilities due to the type of neural network used, the type of models used, etc.), and that may be solved by engaging the retraining system to retrain the model to teach the model to learn to solve the new classification problem (e.g., by feeding it many more labeled instances of correctly classified items). With periodic or continuous evaluation of the performance of the ANN, the DPANN system may subsequently determine that highly stable performance of the ANN (such as where only small improvements of the ANN occur over many iterations of retraining by the retraining system) indicates readiness for the training system to replace the retraining system (or be weighted more favorably where both are involved). Over longer periods of time, cycles of varying performance may emerge, such as where a series of novel problems emerge, such that the retraining system of the DPANN is serially engaged, as needed, to retrain the ANN and/or to augment the ANN by providing a second source of outputs (which may be fused or combined with ANN outputs to provide a single result (with various weightings across them), or may be provided in parallel, such as enabling comparison, selection, averaging, or context- or situation-specific application of the respective outputs).

In embodiments, the ANN is configured to learn new functions in conjunction with the collection of data according to the dual-process training of the ANN via the training system and the retraining system. The DPANN system 12600 performs analysis of the ANN via the training system and performs initial training of the ANN such that the ANN gains new internal functions (or internal functions are subtracted or modified, such as where existing functions are not contributing to favorable outcomes). After the initial training, the DPANN system 12600 performs retraining of the ANN via the retraining system. To perform the retraining, the retraining system evaluates the memory and historic processing of the ANN to construct targeted DPLF processes for retraining. The DPLF processes may be specific to identified scenarios. The ANN processes can run in parallel with the DPLF processes. By way of example, the ANN may function to operate a particular make and model of a self-driving car after the initial training by the training system. The DPANN system 12600 may perform retraining of the functions of the ANN via the retraining system, such as to allow the ANN to operate a different make and model of car (such as one with different cameras, accelerometers and other sensors, different physical characteristics, different performance requirements, and the like), or even a different kind of vehicle, such as a bicycle or a spaceship.

In embodiments, as quality of outputs and/or operations of the ANN improves, and as long as the performance requirements and the context of utilization for the ANN remain fairly stable, performing the dual-process training process can become a decreasingly demanding process. As such, the DPANN system 12600 may determine that fewer neurons of the ANN are required to perform operations and/or processes of the ANN, that performance monitoring can be less intensive (such as with longer intervals between performance checks), and/or that the retraining is no longer necessary (at least for a period of time, such as until a long-term maintenance period arrives and/or until there are significant shifts in context of utilization). As the ANN continues to improve upon existing functions and/or add new functions via the dual-process training process, the ANN may perform other, at times more “intellectually-demanding” (e.g., retraining intensive) tasks simultaneously. For example, utilizing dual process-learned knowledge of a function or process being trained, the ANN can solve an unrelated complex problem or make a retraining decision simultaneously. The retraining may include supervision, such as where an agent (e.g., human supervisor or intelligent agent) directs the ANN to a retraining objective (e.g., “master this new function”) and provides a set of training tasks and feedback functions (such as supervisory grading) for the retraining. In-embodiments, the ANN can be used to organize the supervision, training and retraining of other dual process-trained ANNs, to seed such training or retraining, or the like.

In embodiments, one or more behaviors and operational processes (such as decision-making) of the ANN may be products of training and retraining processes facilitated by the training system and the retraining system, respectively. The training system may be configured to perform automatic training of ANN, such as by continuously adding additional instances of training data as it is collected by or from various data sources. The retraining system may be configured to perform effortful, analytical, intentional retraining of the ANN, such as based on memory (e.g., stored training data or refined training data) and/or optionally based on reasoning or other factors. For example, in a deployment management context, the training system may be associated with a standard response by the ANN, while the retraining system may implement DPLF retraining and/or network adaptation of the ANN. In some cases, retraining of the ANN beyond the factory, or “out-of-the-box,” training level may involve more than retraining by the retraining system. Successful adjustment of the ANN by one or more network adaptations may be dependent on the operation of one or more network adjustments of the training system.

In embodiments, the training system may facilitate fast operating by and training of the ANN by applying existing neural functions of the ANN based on training of the ANN with previous datasets. Standard operational activities of the ANN that may draw heavily on the training system may include one or more of the methods, processes, workflows, systems, or the like described throughout this disclosure and the documents incorporated herein, such as, without limitation: defined functions within networking (such as discovering available networks and connections, establishing connections in networks, provisioning network bandwidth among devices and systems, routing data within networks, steering traffic to available network paths, load balancing across networking resources, and many others); recognition and classification (such as of images, text, symbols, objects, video content, music and other audio content, speech content, and many others); spoken words; prediction of states and events (such as prediction of failure modes of machines or systems, prediction of events within workflows, predictions of behavior in shopping and other activities, and many others); control (such as controlling autonomous or semi-autonomous systems, automated agents (such as automated call-center operations, chat bots, and the like) and others); and/or optimization and recommendation (such as for products, content, decisions, and many others). ANNs may also be suitable for training datasets for scenarios that only require output. The standard operational activities may not require the ANN to actively analyze what is being asked of the ANN beyond operating on well-defined data inputs, to calculate well-defined outputs for well-defined use cases. The operations of the training system and/or the retraining system may be based on one or more historic data training datasets and may use the parameters of the historic data training datasets to calculate results based on new input values and may be performed with small or no alterations to the ANN or its input types. In embodiments, an instance of the training system can be trained to classify whether the ANN is capable of performing well in a given situation, such as by recognizing whether an image or sound being classified by the ANN is of a type that has historically been classified with a high accuracy (e.g., above a threshold).

In embodiments, network adaptation of the ANN by one or both of the training system and the retraining system may include a number of defined network functions, knowledge, and intuition-like behavior of the ANN when subjected to new input values. In such embodiments, the retraining system may apply the new input values to the DPLF system to adjust the functional response of the ANN, thereby performing retraining of the ANN. The DPANN system 12600 may determine that retraining the ANN via network adjustment is necessary when, for example, without limitation, functional neural networks are assigned activities and assignments that require the ANN to provide a solution to a novel problem, engage in network adaptation or other higher-order cognitive activity, apply a concept outside of the domain in which the DPANN was originally designed, support a different context of deployment (such as where the use case, performance requirements, available resources, or other factors have changed), or the like. The ANN can be trained to recognize where the retraining system is needed, such as by training the ANN to recognize poor performance of the training system, high variability of input data sets relative to the historical data sets used to train the training system, novel functional or performance requirements, dynamic changes in the use case or context, or other factors. The ANN may apply reasoning to assess performance and provide feedback to the retraining system. The ANN may be trained and/or retrained to perform intuitive functions, optionally including by a combinatorial or re-combinatorial process (e.g., including genetic programming wherein inputs (e.g., data sources), processes/functions (e.g., neural network types and structures), feedback, and outputs, or elements thereof, are arranged in various permutations and combinations and the ANN is tested in association with each (whether in simulations or live deployments), such as in a series of rounds, or evolutionary steps, to promote favorable variants until a preferred ANN, or preferred set of ANNs is identified for a given scenario, use case, or set of requirements). This may include generating a set of input “ideas” (e.g., combinations of different conclusions about cause-and-effect in a diagnostic process) for processing by the retraining system and subsequent training and/or by an explicit reasoning process, such as a Bayesian reasoning process, a casuistic or conditional reasoning process, a deductive reasoning process, an inductive reasoning process, or others (including combinations of the above) as described in this disclosure or the documents incorporated herein by reference.

Referring to FIG. 126, in embodiments, the DPLF may perform an encoding process of the DPLF to process datasets into a stored form for future use, such as retraining of the ANN by the retraining system. The encoding process enables datasets to be taken in, understood, and altered by the DPLF to better support storage in and usage from the memory. The DPLF may apply current functional knowledge and/or reasoning to consolidate new input values. In the example provided, data is taken in as data input 12602. The memory can include short-term memory (STM) 12604, long-term memory (LTM) 12606, or a combination thereof. The datasets may be stored in one or both of the STM and the LTM. The STM may be implemented by the application of specialized behaviors inside the ANN (such as recurrent neural network, which may be gated or un-gated, or long-term short-term neural networks). The LTM may be implemented by storing scenarios, associated data, and/or unprocessed data that can be applied to the discovery of new scenarios. The encoding process may include processing and/or storing, for example, visual encoding data (e.g., processed through a Convolution Neural Network), acoustic sensor encoding data (e.g., how something sounds, speech encoding data (e.g., processed through a deep neural network (DNN), optionally including for phoneme recognition), semantic encoding data of words, such to determine semantic meaning, e.g., by using a Hidden Markov Model (HMM); and/or movement and/or tactile encoding data (such as operation on vibration/accelerometer sensor data, touch sensor data, positional or geolocation data, and the like). While datasets may enter the DPLF system through one of these modes, the form in which the datasets are stored may differ from an original form of the datasets and may pass-through neural processing engines to be encoded into compressed and/or context-relevant format. For example, an unsupervised instance of the ANN can be used to learn the historic data into a compressed format.

In embodiments, the encoded datasets are retained within the DPLF system. Encoded datasets are first stored in short-term DPLF, i.e., STM. For example, sensor datasets may be primarily stored in STM, and may be kept in STM through constant repetition. The datasets stored in the STM are active and function as a kind of immediate response to new input values. The DPANN system 12600 may remove datasets from STM in response to changes in data streams due to, for example, running out of space in STM as new data is imported, processed and/or stored. For example, it is viable for short-term DPLF to only last between 15 and 30 seconds. STM may only store small amounts of data typically embedded inside the ANN.

In embodiments, the DPANN system 12600 may measure attention based on utilization of the training system, of the DPANN system 12600 as a whole, and/or the like, such as by consuming various indicators of attention to and/or utilization of outputs from the ANN and transmitting such indicators to the ANN in response (similar to a “moment of recognition” in the brain where attention passes over something and the cognitive system says “aha!”). In embodiments, attention can be measured by the sheer amount of the activity of one or both of the systems on the data stream. In embodiments, a system using output from the ANN can explicitly indicate attention, such as by an operator directing the ANN to pay attention to a particular activity (e.g., to respond to a diagnosed problem, among many other possibilities). The DPANN system 12600 may manage data inputs to facilitate measures of attention, such as by prompting and/or calculating greater attention to data that has high inherent variability from historical patterns (e.g., in rates of change, departure from norm, etc.), data indicative of high variability in historical performance (such as data having similar characteristics to data sets involved in situations where the ANN performed poorly in training), or the like.

In embodiments, the DPANN system 12600 may retain encoded datasets within the DPLF system according to and/or as part of one or more storage processes. The DPLF system may store the encoded datasets in LTM as necessary after the encoded datasets have been stored in STM and determined to be no longer necessary and/or low priority for a current operation of the ANN, training process, retraining process, etc. The LTM may be implemented by storing scenarios, and the DPANN system 12600 may apply associated data and/or unprocessed data to the discovery of new scenarios. For example, data from certain processed data streams, such as semantically encoded datasets, may be primarily stored in LTM. The LTM may also store image (and sensor) datasets in encoded form, among many other examples.

In embodiments, the LTM may have relatively high storage capacity, and datasets stored within LTM may, in some scenarios, be effectively stored indefinitely. The DPANN system 12600 may be configured to remove datasets from the LTM, such as by passing LTM data through a series of memory structures that have increasingly long retrieval periods or increasingly high threshold requirements to trigger utilization (similar to where a biological brain “thinks very hard” to find precedent to deal with a challenging problem), thereby providing increased salience of more recent or more frequently used memories while retaining the ability to retrieve (with more time/effort) older memories when the situation justifies more comprehensive memory utilization. As such, the DPANN system 12600 may arrange datasets stored in the LTM on a timeline, such as by storing the older memories (measured by time of origination and/or latest time of utilization) on a separate and/or slower system, by penalizing older memories by imposing artificial delays in retrieval thereof, and/or by imposing threshold requirements before utilization (such as indicators of high demand for improved results). Additionally or alternatively, LTM may be clustered according to other categorization protocols, such as by topic. For example, all memories proximal in time to a periodically recognized person may be clustered for retrieval together, and/or all memories that were related to a scenario may be clustered for retrieval together.

In embodiments, the DPANN system 12600 may modularize and link LTM datasets, such as in a catalog, a hierarchy, a cluster, a knowledge graph (directed/acyclic or having conditional logic), or the like, such as to facilitate search for relevant memories. For example, all memory modules that have instances involving a person, a topic, an item, a process, a linkage of n-tuples of such things (e.g., all memory modules that involve a selected pair of entities), etc. The DPANN system 12600 may select sub-graphs of the knowledge graph for the DPLF to implement in one or more domain-specific and/or task-specific uses, such as training a model to predict robotic or human agent behavior by using memories that relate to a particular set of robotic or human agents, and/or similar robotic or human agents. The DPLF system may cache frequently used modules for different speed and/or probability of utilization. High value modules (e.g., ones with high-quality outcomes, performance characteristics, or the like) can be used for other functions, such as selection/training of STM keep/forget processes.

In embodiments, the DPANN system 12600 may modularize and link LTM datasets, such as in various ways noted above, to facilitate search for relevant memories. For example, memory modules that have instances involving a person, a topic, an item, a process, a linkage of n-tuples of such things (such as all memory modules that involve a selected pair of entities), or all memories associated with a scenario, etc., may be linked and searched. The DPANN system 12600 may select subsets of the scenario (e.g., sub-graphs of a knowledge graph) for the DPLF for a domain-specific and/or task-specific use, such as training a model to predict robotic or human agent behavior by using memories that relate to a particular set of robotic or human agents and/or similar robotic or human agents. Frequently used modules or scenarios can be cached for different speed/probability of utilization, or other performance characteristics. High value modules or scenarios (ones where high-quality outcomes results) can be used for other functions, such as selection/training of STM keep/forget processes, among others.

In embodiments, the DPANN system 12600 may perform LTM planning, such as to find a procedural course of action for a declaratively described system to reach its goals while optimizing overall performance measures. The DPANN system 12600 may perform LTM planning when, for example, a problem can be described in a declarative way, the DPANN system 12600 has domain knowledge that should not be ignored, there is a structure to a problem that makes the problem difficult for pure learning techniques, and/or the ANN needs to be trained and/or retrained to be able to explain a particular course of action taken by the DPANN system 12600. In embodiments, the DPANN system 12600 may be applied to a plan recognition problem, i.e., the inverse of a planning problem: instead of a goal state, one is given a set of possible goals, and the objective in plan recognition is to find out which goal was being achieved and how.

In embodiments, the DPANN system 12600 may facilitate LTM scenario planning by users to develop long-term plans. For example, LTM scenario planning for risk management use cases may place added emphasis on identifying extreme or unusual, yet possible, risks and opportunities that are not usually considered in daily operations, such as ones that are outside a bell curve or normal distribution, but that in fact occur with greater-than-anticipated frequency in “long tail” or “fat tail” situations, such as involving information or market pricing processes, among many others. LTM scenario planning may involve analyzing relationships between forces (such as social, technical, economic, environmental, and/or political trends) in order to explain the current situation, and/or may include providing scenarios for potential future states.

In embodiments, the DPANN system 12600 may facilitate LTM scenario planning for predicting and anticipating possible alternative futures along with the ability to respond to the predicted states. The LTM planning may be induced from expert domain knowledge or projected from current scenarios, because many scenarios (such as ones involving results of combinatorial processes that result in new entities or behaviors) have never yet occurred and thus cannot be projected by probabilistic means that rely entirely on historical distributions. The DPANN system 12600 may prepare the application to LTM to generate many different scenarios, exploring a variety of possible futures to the DPLM for both expected and surprising futures. This may be facilitated or augmented by genetic programming and reasoning techniques as noted above, among others.

In embodiments, the DPANN system 12600 may implement LTM scenario planning to facilitate transforming risk management into a plan recognition problem and apply the DPLF to generate potential solutions. LTM scenario induction addresses several challenges inherent to forecast planning. LTM scenario induction may be applicable when, for example, models that are used for forecasting have inconsistent, missing, unreliable observations; when it is possible to generate not just one but many future plans; and/or when LTM domain knowledge can be captured and encoded to improve forecasting (e.g., where domain experts tend to outperform available computational models). LTM scenarios can be focused on applying LTM scenario planning for risk management. LTM scenarios planning may provide situational awareness of relevant risk drivers by detecting emerging storylines. In addition, LTM scenario planning can generate future scenarios that allow DPLM, or operators, to reason about, and plan for, contingencies and opportunities in the future.

In embodiments, the DPANN system 12600 may be configured to perform a retrieval process via the DPLF to access stored datasets of the ANN. The retrieval process may determine how well the ANN performs with regard to assignments designed to test recall. For example, the ANN may be trained to perform a controlled vehicle parking operation, whereby the autonomous vehicle returns to a designated spot, or the exit, by associating a prior visit via retrieval of data stored in the LTM. The datasets stored in the STM and the LTM may be retrieved by differing processes. The datasets stored in the STM may be retrieved in response to specific input and/or by order in which the datasets are stored, e.g., by a sequential list of numbers. The datasets stored in the LTM may be retrieved through association and/or matching of events to historic activities, e.g., through complex associations and indexing of large datasets.

In embodiments, the DPANN system 12600 may implement scenario monitoring as at least a part of the retrieval process. A scenario may provide context for contextual decision-making processes. In embodiments, scenarios may involve explicit reasoning (such as cause-and-effect reasoning, Bayesian, casuistic, conditional logic, or the like, or combinations thereof) the output of which declares what LTM-stored data is retrieved (e.g., a timeline of events being evaluated and other timelines involving events that potentially follow a similar cause-and-effect pattern). For example, diagnosis of a failure of a machine or workflow may retrieve historical sensor data as well as LTM data on various failure modes of that type of machine or workflow (and/or a similar process involving a diagnosis of a problem state or condition, recognition of an event or behavior, a failure mode (e.g., a financial failure, contract breach, or the like), or many others).

FIG. 127 shows a biology based transaction system and FIG. 128 shows a thalamus service 12700 and a set of input sensors streaming data from various sources across a system 12702 with its centrally-managed data sources 12704. The thalamus service 12700 filters the into the control system 12702 such that the control system is never overwhelmed by the total volume of information. In embodiments, the thalamus service 12700 provides an information suppression mechanism for information flows within the system. This mechanism monitors all data streams and strips away irrelevant data streams by ensuring that the maximum data flows from all input sensors are always constrained.

The biology-based transaction system include a PMCP devices interface and the control system. The PMCP devices interface may be associated with a PMCP API, an intelligence system a PMCP controller, classification, behavior analysis, prediction, augmentation, a networking module, a security module, an ETL interface, or a PMCP database. The control system may include the intelligence service 12710, a quantum computing service, and the intake management system 12706. The intake management system 12706 may include an intake application library with networking and security, an intelligence system, an intake learning module, configured thalamus parameters, the intake controller 12718, and an intake management system with prioritizing, area focus, formatting, filtering, suppression, and combining.

The thalamus service 12700 may be a gateway for all communication that responds to the prioritization of the control system 12702. The control system 12702 may decide to change the prioritization of the data streamed from the thalamus service 12700, for example, during a known fire in an isolated area, and the event may direct the thalamus service 12700 to continue to provide flame sensor information despite the fact that majority of this data is not unusual. The thalamus service 12700 may be an integral part of the overall system communication framework.

In embodiments, the thalamus service 12700 includes an intake management system 12706. The intake management system 12706 may be configured to receive and process multiple large datasets by converting them into data streams that are sized and organized for subsequent use by a central control system 12702 operating within one or more systems. For example, a robot may include vision and sensing systems that are used by its central control system 12702 to identify and move through an environment in real time. The intake management system 12706 can facilitate robot decision-making by parsing, filtering, classifying, or otherwise reducing the size and increasing the utility of multiple large datasets that would otherwise overwhelm the central control system 12702. In embodiments, the intake management system may include an intake controller 12708 that works with an intelligence service 12710 to evaluate incoming data and take actions-based evaluation results. Evaluations and actions may include specific instruction sets received by the thalamus service 12700, for example the use of a set of specific compression and prioritization tools stipulated within a “Networking” library module. In another example, thalamus service inputs may direct the use of specific filtering and suppression techniques. In a third example, thalamus service inputs may stipulate data filtering associated with an area of interest such as a certain type of financial transaction. The intake management system is also configured to recognize and manage datasets that are in a vectorized format such as PCMP, where they may be passed directly to central control, or alternatively deconstructed and processed separately. The intake management system 12706 may include a learning module that receives data from external sources that enables improvement and creation of application and data management library modules. In some cases, the intake management system may request external data to augment existing datasets.

In embodiments the control system 12702 may direct the thalamus service 12700 to alter its filtering to provide more input from a set of specific sources. This indication more input is handled by the thalamus service 12700 by suppressing other information flows based to constrain the total data flows to within a volume the central control system can handle.

The thalamus service 12700 can operate by suppressing data based on several different factors, and in embodiments, the default factor maybe unusualness of the data. This unusualness is a constant monitoring of all input sensors and determining the unusualness of the data.

In some embodiments, the thalamus service 12700 may suppress data based on geospatial factors. The thalamus service 12700 may be aware of the geospatial location of all sensors and is able to look for unusual patterns in data based on geospatial context and suppress data accordingly.

In some embodiments, the thalamus service 12700 may suppress data based on temporal factors. Data can be suppressed temporally, for example, if the cadence of the data can be reduced such that the overall data stream is filtered to level that can be handled by the central processing unit.

In some embodiments, the thalamus service 12700 may suppress data based on contextual factors. In embodiments, context-based filtering is a filtering event in which the thalamus service 12700 is aware of some context-based event. In this context the filtering is made to suppress information flows not relating to the data from the event.

In embodiments, the control system 12702 can override the thalamus filtering and decide to focus on a completely different area for any specific reason.

In embodiments, the system may include a vector module. In embodiments, the vector module may be used to convert data to a vectorized format. In many examples, the conversion of a long sequence of oftentimes similar numbers into a vector, which may include short term future predictions, makes the communication both smaller in size and forward looking in nature. In embodiments, forecast methods may include: moving average; weighted moving average; Kalman filtering; exponential smoothing; autoregressive moving average (ARMA) (forecasts depend on past values of the variable being forecast, and on past prediction errors); autoregressive integrated moving average (ARIMA) (ARMA on the period-to-period change in the forecasted variable); extrapolation; linear prediction; trend estimation (predicting the variable as a linear or polynomial function of time); growth curve (e.g., statistics); and recurrent neural network.

In embodiments, the system may include a predictive model communication protocol (PMCP) system to support vector-based predictive models and a predictive model communication protocol (PMCP). Under the PMCP protocol, instead of traditional streams where individual data items are transmitted, vectors representing how the data is changing or what is the forecast trend in the data is communicated. The PMCP system may transmit actual model parameters and receiving units such that edge devices can apply the vector-based predictive models to determine future states. For example, each automated device in a network could train a regression model or a neural network, constantly fitting the data streams to current input data. All automated devices leveraging the PMCP system would be able to react in advance of events actually happening, rather than waiting for depletion of inventory for an item, for example, to occur. Continuing the example, the stateless automated device can react to the forecast future state and make the necessary adjustments, such as ordering more of the item.

In embodiments, the PMCP system enables communicating vectorized information and algorithms that allow vectorized information to be processed to refine the known information regarding a set of probability-based states. For example, the PMCP system may support communicating the vectorized information gathered at each point of a sensor reading but also adding algorithms that allow the information to be processed. Applied in an environment with large numbers of sensors with different accuracies and reliabilities, the probabilistic vector-based mechanism of the PMCP system allows large numbers, if not all, data streams to combine to produce refined models representing the current state, past states and likely future states of goods. Approximation methods may include importance sampling, and the resulting algorithm is known as a particle filter, condensation algorithm, or Monte Carlo localization.

In embodiments, the vector-based communication of the PMCP system allows future security events to be anticipated, for example, by simple edge node devices that are running in a semi-autonomous way. The edge devices may be responsible for building a set of forecast models showing trends in the data. The parameters of this set of forecast models may be transmitted using the PMCP system.

Security systems are constantly looking for vectors showing change in state, as unusual events tend to trigger multiple vectors to show unusual patterns. In a security setting, seeing multiple simultaneous unusual vectors may trigger escalation and a response by, for example, the control system. In addition, one of the major areas of communication security concern is around the protection of stored data, and in a vector-based system data does not need to be stored, and so the risk of data loss is simply removed.

In embodiments, PMCP data can be directly stored in a queryable database where the actual data is reconstructed dynamically in response to a query. In some embodiments, the PMCP data streams can be used to recreate the fine-grained data so they become part of an Extract Transform and Load (ETL) process.

In embodiments where there are edge devices with very limited capacities, additional edge communication devices can be added to convert the data into PMCP format. For example, to protect distributed medical equipment from hacking attempts many manufacturers will choose to not connect the device to any kind of network. To overcome this limitation, the medical equipment may be monitored using sensors, such as cameras, sound monitors, voltage detectors for power usage, chemical sniffers, and the like. Functional unit learning and other data techniques may be used to determine the actual usage of the medical equipment detached from the network functional unit.

Communication using vectorized data allows for a constant view of likely future states. This allows the future state to be communicated, allowing various entities to respond ahead of future state requirements without needing access to the fine-grained data.

In embodiments, the PMCP protocol can be used to communicate relevant information about production levels and future trends in production. This PMCP data feed, with its built-in data obfuscation allows real contextual information about production levels to be shared with consumers, regulators, and other entities without requiring sensitive data to be shared. For example, when choosing to purchase a new car, if there is an upcoming shortage of red paint then the consumer could be encouraged to choose a different color in order to maintain a desired delivery time. PMCP and vector data enables simple data informed interactive systems that user can apply without having to build enormously complex big data engines. As an example, an upstream manufacturer has an enormously complex task of coordinating many downstream consumption points. Through the use of PMCP, the manufacturer is able to provide real information to consumers without the need to store detailed data and build complex models.

In embodiments, edge device units may communicate via the PMCP system to show direction of movement and likely future positions. For example, a moving robot can communicate its likely track of future movement.

In embodiments, the PMCP system enables visual representations of vector-based data (e.g., via a user interface), highlighting of areas of concern without the need to process enormous volumes of data. The representation allows for the display of many monitored vector inputs. The user interface can then display information relating to the key items of interest, specifically vectors showing areas of unusual or troublesome movement. This mechanism allows sophisticated models that are built at the edge device edge nodes to feed into end user communications in a visually informative way.

Functional units produce a constant stream of “boring” data. By changing from producing data, to being monitored for problems, issues with the logistical modules are highlighted without the need for scrutiny of fine-grained data. In embodiments, the vectorizing process could constantly manage a predictive model showing future state. In the context of maintenance, these changes to the parameters in the predictive model are in and of themselves predictors of change in operational parameters, potentially indicating the need for maintenance. In embodiments, functional areas are not always designed to be connected, but by allowing for an external device to virtually monitor devices, functional areas that do not allow for connectivity can become part of the information flow in the goods. This concept extends to allow functional areas that have limited connectivity to be monitored effectively by embellishing their data streams with vectorized monitored information. Placing an automated device in the proximity of the functional unit that has limited or no connectivity allows capture of information from the devices without the requirement of connectivity. There is also potential to add training data capture functional units for these unconnected or limitedly connected functional areas. These training data capture functional units are typically quite expensive and can provide high quality monitoring data, which is used as an input into the proximity edge device monitoring device to provide data for supervised learning algorithms.

Oftentimes, locations are laden with electrical interference, causing fundamental challenges with communications. The traditional approach of streaming all the fine-grained data is dependent on the completeness of the data stream. For example, if an edge device was to go offline for 10 minutes, the streaming data and its information would be lost. With vectorized communication, the offline unit continues to refine the predictive model until the moment when it reconnects, which allows the updated model to be transmitted via the PMCP system.

In embodiments, systems and devices may be based on the PMCP protocol. For example, cameras and vision systems (e.g., liquid lens systems), user devices, sensors, robots, smart containers, and the like may use PMCP and/or vector-based communication. By using vector-based cameras, for example, only information relating to the movement of items is transmitted. This reduces the data volume and by its nature filters information about static items, showing only the changes in the images and focusing the data communication on elements of change. The overall shift in communication to communication of change is similar to how the human process of sight functions, where stationary items are not even communicated to the higher levels of the brain.

Radio Frequency Identification allows for massive volumes of mobile tags to be tracked in real-time. In embodiments, the movement of the tags may be communicated as vector information via the PMCP protocol, as this form of communication is naturally suited to handing information regarding the location of tag within the goods. Adding the ability to show future state of the location using predictive models that can use paths of prior movement allows the goods to change the fundamental communication mechanism to one where units consuming data streams are consuming information about the likely future state of the goods. In embodiments, each tagged item may be represented as a probability-based location matrix showing the likely probability of the tagged item being at a position in space. The communication of movement shows the transformation of the location probability matrix to a new set of probabilities. This probabilistic locational overview provides for constant modeling of areas of likely intersection of moving units and allows for refinement of the probabilistic view of the location of items. Moving to a vector-based probability matrix allows units to constantly handle the inherent uncertainty in the measurement of status of various items, entities, and the like. In embodiments, status includes, but is not limited to, location, temperature, movement and power consumption.

In embodiments, continuous connectivity is not required for continuous monitoring of sensor inputs in a PMCP-based communication system. For example, a mobile robotic device with a plurality of sensors will continue to build models and predictions of data streams while disconnected from the network, and upon reconnection, the updated models are communicated. Furthermore, other systems or devices that use input from the monitored system or device can apply the best known, typically last communicated, vector predictions to continue to maintain a probabilistic understanding of the states of the goods.

### Marketplaces for Process Automation and Artificial Intelligence, Market Aggregation, and Embedded Marketplaces

In example embodiments, a marketplaces function may be used as a starting point for nearly every interaction for businesses and consumers to have with goods and services. Digital Marketplaces may be prevalent due to advances in connectivity, a desire for convenience, and real-time personalization. As trends have evolved, the transaction may now be prioritized (e.g., front of mind). Classifieds shifting towards full-stack marketplaces aiming to capture relatively more of the transaction may be expanding and/or speeding up. The simplest form of a transaction environment (e.g., a marketplace or a set of marketplaces) may have one product or service that may be sold through a transaction between a buyer and a seller. In example embodiments, the transaction environment may be a marketplace or a set of marketplaces. Most marketplaces may evolve from selling one thing to selling a variety of things by leveraging their technology and platform to expand and diversify. Since many of existing local services were focused heavily on discovery, monetizing the matchmaking may be an adequate way to start this process. As consumer expectations have started to develop, and combined with the fact that software enables “stickiness”; these new marketplaces may monetize each transaction relatively more efficiently. Marketplaces have become relatively more verticalized and hyper-focused, however sustaining that growth may require focus on providing amazing customer experience and delivering value on each and every transaction.

In example embodiments, creating vertically integrated marketplaces within specific niches, especially that within transactions, may allow consumers to start and end their search within an entire ecosystem. This may provide for the resulting definition of an end-to-end frictionless solution. In business terms, this may provide for creating stickiness and resilience. Greater transaction ownership may result in reducing friction and creating greater convenience that may require greater operational complexity. Artificial Intelligence and Machine Learning may allow for the customization of this exploration and provision of options that may require in-depth understanding of user data.

### Process Automation and Artificial Intelligence

Intelligent machines, rather than people, may make more and more decisions about what to buy, and at what price, and complete the transactions without a middleman (this may be in conjunction with a blockchain distributed ledger). This may mean new markets for various things from home supplies ordered via “smart speakers” such as Amazon Echo™ to electricity ordered by smart thermostats to replacement parts and raw materials purchased by manufacturing robots or optimization algorithms for cyber-physical systems of machines. These developments may also likely create “algorithmic profits” through transaction fees charged by the software that may match buyers and/or sellers or aggregate the needs of machines. The disclosure may aim to facilitate transactions between and among digital twins and machines (e.g., machine-to-machine), broadly classified as “Machine Customers” (a term that has recently gained traction in the market). This disclosure includes an overview of methodologies for exploiting and creating new business models around the needs and capabilities of increasingly intelligent and autonomous machines while aligning these models with the needs of human society and desired business outcomes.

Internet has enabled a whole new ecosystem to flourish where Internet of Things (IoT) devices, such as home appliances, automobiles, industrial machinery, and infrastructure equipped with smart sensors, actuators, memory modules, and processors, may be capable of exchanging real-time information across systems and networks. The data generated by such IoT devices offers great value. It may assist in assessing consumption behavior and usage patterns and may also serve to inform macro-level tasks like city planning and assessing the quality and demand of water across a region. Additionally, device owners may willingly sell selected data points for monetary rewards. This has led to machine-driven Machine-to-Machine (M2M) economy (more ubiquitously referred to as Machine-to-Everything (M2X) economy), where the smart, autonomous, networked, and economically independent machines or devices may act as the participants, carrying on the necessary activities of production, distribution, and allocation with little to no human intervention.

As part of the advancements using artificial intelligence (AI) and the internet of things (IoT), machines may now include payments technology, that is machines becoming active participants in the transactions environment. Machine-to-machine payments are changing the payments industry landscape, with device-agnostic solutions bringing the once isolated systems together to communicate and make autonomous choices. Examples of Machine-to-Machine payments may include power and energy trading between smart grids and homes, industrial machines paying 3D printers to print replacement parts, and/or connected vehicles paying for parking. The benefits of using machine-to-machine payments for a user may include, but may not be limited to: automation (e.g., may not forget to replenish an item again, and machine-to-machine payments automatically purchase the items a consumer needs before they need them); contactless (e.g., payments may get completed with no human contact or interaction); cashless and cardless (e.g., no need to worry about remembering cash, a debit, or credit card to make a purchase); autonomous purchases based on preferences (e.g., due to the connected nature and knowledge that these machines hold, they may make purchases based on customer preference without any additional actions needed); etc.

However, existing technologies may not provide a framework that supports the corresponding multi-stakeholder ecosystem and facilitates M2X value exchange, collaborations, and business enactments. Current market economy has been primarily developed for Human-to-Human business, which is typically governed by contracts either in the form of oral, or written agreements. M2X ecosystem may require a digital equivalent of such market economy which may then enable mapping of machine payments, compliance checks, interoperability, complex and comprehensive reporting, security, etc. as may be required in a distributed multi-stakeholder setting.

Process Automation and Artificial Intelligence (PAAI) is a theme of technologies that may help with compliance, regulations, and standardization in the marketplaces. In the last few years, a digital twin (DT) paradigm has been explored in different domains as an approach to virtualize entities existing in the real world, creating software counterparts that may provide smart services upon them. Such services may range from simple tracking of the actual state of the physical entity or device to smarter forms of monitoring in order to, e.g., detect and predict possible critical situations, optimize performances, up to more general forms of augmentation of the capabilities of the physical counterpart. Relevant examples may be found in healthcare, industries, finance, smart cities, etc. Despite the specific domain and implementation, models of DT may share two main characteristics: (i) they typically concern virtualization of individual, standalone assets, in a closed-system perspective, being them physical objects, products, machines, buildings, etc.; and (ii) they may be used for vertical applications such as designed for specific purposes. Beyond this view, the DT principles and paradigm may be extended to the virtualization of complex realities composed of interrelated assets, possibly belonging to different domains and different organizations, in a relatively more open-system perspective.

FIG. 129 provides an exemplary block diagram illustration of a transaction environment (e.g., a marketplace or a set of marketplaces) such as a marketplace 12900. The marketplace 12900 may include multiple enterprises 12902. The term “enterprise” in traditional use may identify any individual undertaking. The term enterprise may also identify a complete business. Within the context of European Securities and Markets Authority (ESMA) Solution Framework (and ESMA in general), an enterprise may be comprised of those business undertakings defined as important to customers. Customers may define what an enterprise is to them. This may be as small as a single server, or as large as an integrated manufacturing and distribution application. Herein, the enterprise 12902 may include enterprise devices 12904, enterprise resources 12906, private blockchain(s) 12908, and enterprise datastores 12910. The marketplace 12900 may also include an enterprise access layer 12920 which may allow the enterprise(s) 12902 to communicate with other elements in the marketplace 12900. The enterprise access layer 12920 may include a workflow system 12922, an interface system 12924, a data services system 12926, an intelligence system 12928, a permissions system 12930, a wallets system 12932, and a reporting system 12934.

The marketplace 12900 may further include marketplace participants 12940. Herein, the marketplace participants 12940 may include buyers/customers 12942 and sellers/providers 12944. The marketplace 12900 may also provide a platform 12950 for connecting the buyers/customers 12942 and the sellers/providers 12944 with the enterprises 12902 providing solutions for integration of various services in the marketplace 12900. The platform 12950 may be a software application that provides online commerce for the buyers/customers 12942 and the sellers/providers 12944. In example embodiments, the platform 12950 may be an e-commerce platform that may manage web hosting, inventory management, payment processing, marketing, order fulfillment, and more.

M2M (Machine to Machine) Types of Transactions with Digital Twin (Related to Software and/or Hardware)-Automation of Software Orchestrated Transactions

Machine-to-machine types of activity that play out in the context of technologies such as digital twins and robotic process automation (e.g., related to software and possibly even hardware) may provide interesting capabilities. FIG. 130 provides an exemplary block diagram illustration of a system 13000 implementing a processing system 13010 for automation of transactions in the marketplace 12900. Herein, the processing system 13010 may be configured to generate a digital twin 13002 of the marketplace 12900. The digital twin 13002 may be a digital representation of a structure of the marketplace 12900, with the structure being representative of a set of entities of the marketplace 12900 including items in the marketplace 12900, parties in the marketplace 12900, and one or more IoT devices associated with each one of the parties in the marketplace 12900. In example embodiments, the term “items” as used herein may include physical or virtual goods that require delivery or may be downloaded from the marketplace 12900. In example embodiments, the term “parties” as used herein may include the enterprise(s) 12902, the buyers/customers 12942, and the sellers/providers 12944 in the marketplace 12900. In example embodiments, the term “IoT devices” as used herein may include smart mobiles, smart refrigerators, smartwatches, smart fire alarms, smart door locks, smart bicycles, medical sensors, fitness trackers, smart security system, etc.

In example embodiments, the processing system 13010 may be configured to generate the digital twin 13002(s) of the marketplace 12900 based on information about the items in the marketplace 12900 including at least one of: current price of each of the items, price history of each of the items, order history of each of the items, or a service history of each of the items. In example embodiments, the parties in the marketplace 12900 may include at least one of: transaction history of each of the parties, risk profile of each of the parties, social data of the each of the parties, or item portfolio of the each of the parties. In example embodiments, the one or more IoT devices associated with each one of the parties in the marketplace 12900 may include at least one of: a type of each of the one or more IoT devices or a capability of each of the one or more IoT devices.

In example embodiments, digital twin(s) 13002 may unlock a new archetype for creating or sharing data quickly and securely to accelerate the experimentation and validation of commercial innovations in the financial services industry. These allow businesses to access several kinds of data such as consumer data, enterprise data, and/or industry data to test and validate their innovative solutions in the marketplace 12900. The speed and scalability of generating synthetic datasets may be additional value-adds that help businesses reduce the time to market and allow them to experiment with various alternate scenarios cost-effectively. Recent advancements in Internet of Things (IoT), big data, and machine learning may have significantly contributed to the improvements in the digital twin(s) 13002 regarding their real-time capabilities and forecasting properties. Collected data may constitute the so-called digital threads and may be the grounding information on which simulation or machine learning algorithms may rely to make predictions, identify failures to be anticipated, to optimize the system 13000, to design novel features, to ease and accelerate decision making, and to improve productivity, for example. According to this definition, the digital twins 13002 may not only provide a model of the physical asset, but it may autonomously evolve through simulation and AI-enabled algorithms to understand the world, learn, reason, and answer questions (e.g., what-if questions).

In example embodiments, the digital twin(s) 13002 may also allow for flexibility to inject multiple scenarios to generate different dynamic datasets to test out a gamut of alternate scenarios during development and quality assurance stages to ensure innovation use-cases perform well in various real-life scenarios and business events in the marketplace 12900. The digital twin(s) 13002 may be implemented to ensure that the marketplace 12900 be fair for everyone to be able to view into the marketplace in real time. The digital twin(s) 13002 may be utilized to garner trust that the marketplace 12900 is fair and that the roles of governance and policy may be seen and monitored in real time with the digital twin(s) 13002. The digital twin(s) 13002 may facilitate the organization of these software defined markets such as the ability to monitor them, understand the rules that govern them in real time, and watch them as they comply or not comply with roles. In general, the digital twin(s) 13002 may be implemented to manage the marketplace 12900 and display what may be fair by representing various things about a marketplace such as: where are the computers that are participating, who are the entities, where is the data, what are current latency levels for transactors, what are rules (e.g., holding, timing, asset types, quarantine, etc.), and the like.

In example embodiments, digital twin(s) 13002 may have applications in a machine-to-machine (M2M) ecosystem as provided in the marketplace 12900. For instance, digital twin(s) 13002 may be employed in healthcare billing such as where a magnetic resonance imaging (MRI) machine may be running and outputting a data stream, that knows it has taken a patient through an MRI, and knows who the patient is (e.g., all registered in order to run the MRI) because it may be supported in an infrastructure (e.g., IT system). This system may speak in a machine-to-machine way with the digital twin 13002 of the patient and kick off a transactional record to a distributed ledger which may be tracking the fact that a patient has accumulated a number of radiology events in a time period (e.g., the past year). This may allow for improved tuning of healthcare plans that get imaging under a given billing regime, or under doctor's recommendations to try to limit radiation exposure that accumulates. Another example may include the digital twin 13002 of a patient's health condition such that the system 13000 may anticipate health procedures and interventions that may be needed, and having a pricing function where it may identify services and pricing estimates in a location in order to remove opacity from how health care services are priced currently. Further, with incorporation of machine-to-machine transfers/transactions, the digital twin(s) 13002 may use simulation features such as multiple simulations of making small variances throughout, and then trying to use these simulations to gain a consensus in the future based on the outcomes of these simulations.

In example embodiments, the digital twin(s) 13002 may be implemented with smart contracts with, such as for digital twin transactions enabled by smart contracts (e.g., using smart contract orchestration engines), leading to the marketplace 12900 being a decentralized marketplace (with the two terms being interchangeably used). The decentralized marketplace 12900 may be a marketplace that does not have a single entity owning or managing it, which in turn enhances its security, resiliency, transparency, and traceability. The decentralized marketplace 12900 may be partially decentralized, where for example a group of independent agriculture producers and retailers may be managing it, or fully decentralized where anyone may join and use the marketplace. Such decentralized marketplace 12900 may utilize a public blockchain(s) 13004 for providing distributed ledger technologies (DLTs) which may allow for creation of both types of such decentralized marketplaces 13000. By calling the functions of the smart contracts of the marketplace 12900, different parties may observe the state of the marketplace 12900, make transactions they have permission for, and subsequently change the state of the marketplace 12900.

For instance, in an example implementation, upon a change in the rules that govern whether an entity may participate in a marketplace and/or the types of transactions that may be permitted, a set of automated agents may automatically reconfigure smart contract terms and conditions (such as buy/sell offers; futures contracts; options; etc.) for a set of orders/instructions and represent the aggregate set in a digital twin, such as showing comparative differences between orders and a preexisting set, comparison to a defined strategy (e.g., to liquidate a position over time), gaps that need to be filled (such as by manual trades), and the like. The agents may automatically update smart contract terms and conditions, identify non-compliant terms and conditions in existing contracts, propose corrections/amendments to existing contracts, and the like, e.g., to increase costs of transactions depending on market conditions.

In example embodiments, the digital twin 13002 of the marketplace 12900 may be a web of digital twins of the parties in the marketplace 12900. The Web of Digital Twins (WoDT) may provide a broader perspective in which the digital twin paradigm may be exploited for the pervasive “softwarization” of possibly large-scale interrelated physical realities. The WoDT may be conceived as an open, distributed and dynamic ecosystem of connected digital twins, functioning as an interoperable service-oriented layer for applications running on top, especially smart applications and multiagent systems.

In the marketplace 12900, the processing system 13010 may be configured to determine a utilization of one of the items by at least one of the parties or a requirement of one of the items by one of the parties by implementing the digital twin 13002 of the marketplace 12900. The marketplace 12900 may include a set of data (such as the stipulations of requests and offers, details of services and products, history of the previous transactions, information about the managers, regulations of the marketplace, etc.), and operations with different access permissions (e.g., adding new requests and offers, changing the states of those requests and offers, selecting the best set of offers for a request based on predefined criteria, modifying the roles of managers, getting information about different entities of the marketplace, etc.). The digital twin 13002 may use such data to determine the utilization of one of the items by at least one of the parties or a requirement of one of the items by one of the parties. For example, where 30/40 simulations running may identify a battery recall requirement, then the system 13000 may trigger a contract for lithium, or another resource needed. In summary, such implementation may relate to identifying a consumer need and when to buy it, using the simulation feature of the digital twins 13002.

Further, the processing system 13010 may be configured to facilitate a transaction between at least one of the parties providing the at least one of the items and at least one of the parties having the utilization or the requirement of the at least one of the items based on the determination. In example embodiments, the processing system 13010 may be configured to place an order for a given item for a given party based on the determination of the utilization of one of the items by at least one of the parties or the requirement of one of the items by one of the parties. The processing system 13010 may be further configured to process an automated payment for the order using payment details of the given party. This may be achieved via machine-to-machine payments which may be automated payments between machines via digital wallets without the need of any action or any confirmation by humans. In some examples, the transactions may be pre-defined transactions that auto-execute based on events, outcomes, or changes in data.

FIG. 131 provides an exemplary block diagram illustration of the processing system 13010 showing various modules therein. These modules may be implemented for achieving different applications for automation of transactions in the marketplace 12900. As illustrated, the processing system 13010 may include an automated order placement module 13020, an automated price adaption module 13030, an automated inventory forecasting module 13040, and an automated inventory procurement module 13050.

In example embodiments, there may be an implementation of the digital twin 13002 for predicting price fluctuations, such that one may use the digital twin and then the simulations to time an automated transaction based on when a user is going to need a good or service they are buying and when is optimal pricing of the same good or service. For such purpose, the processing system 13010 may implement the automated order placement module 13020 for automated placement of an order in the marketplace 12900. Herein, the automated order placement module 13020 may be configured to forecast price of a given item in the marketplace 12900 for a defined time period by implementing the digital twin 13000 of the marketplace 12900. Further, the automated order placement module 13020 may be configured to estimate a lowest forecasted price of the given item in the defined time period based on the forecasting of the price of the given item in the marketplace 12900 for the defined time period. The automated order placement module 13020 may be further configured to determine a price difference between the lowest forecasted price of the given item and a current price of the given item. Based on that, the automated order placement module 13020 may be further configured to schedule an order for the given item for a time corresponding to the lowest forecasted price of the given item if the price difference may be above a defined price threshold. In example embodiments, the automated order placement module 13020 may be further configured to define at least one of the time period or the price threshold based on an urgency of the requirement of the given item by implementing the digital twin 13002 of the marketplace 12900.

In example embodiments, there may be an implementation of the digital twin 13002 for price adaptation which may be the ability of a business to change its pricing models to suit different geographic areas, consumer demands, and/or prevailing incomes. Demand-based pricing may come in a variety of forms-all united by the fact that they play on consumer demand. These methods may vary based on several factors, including: a company's business goals, its place in its market, consumer preferences, and the quality of its product. For such purpose, the processing system 13010 may implement the automated price adaption module 13030 for automated price adaption in the marketplace 12900. Herein, the automated price adaption module 13030 may be configured to determine a current demand of a given item in the marketplace 12900, by implementing the digital twin 13000 of the marketplace 12900. The automated price adaption module 13030 may be further configured to adapt a current price of the given item in the marketplace 12900 based on the current demand thereof. In an example, if the demand of a particular item is high, then its price may be increased, and vice-versa, as per the market dynamics of the marketplace 12900.

In example embodiments, there may be an implementation of the digital twin 13002 for inventory forecasting, also known as demand planning, which may be the practice of using past data, trends, and known upcoming events to predict needed inventory levels for a future period. Accurate forecasting ensures businesses have enough product to fulfill customer orders while not tying up cash in unnecessary inventory. An accurate inventory forecast may be invaluable, especially in times when supply chains and consumer demand are changing rapidly. Getting forecasts correct may require a mix of data analysis, experience in the industry, and customer insights to predict future demand. For such purpose, the processing system 13010 may implement the automated inventory forecasting module 13040 for automated inventory forecasting in the marketplace 12900. Herein, the automated inventory forecasting module 13040 may be configured to determine a forecasted demand of a given item in the marketplace 12900, by implementing the digital twin 13000 of the marketplace 12900. The automated inventory forecasting module 13040 may be further configured to generate an inventory forecast for one or more of the parties providing the given item based on the forecasted demand thereof. The automated inventory forecasting module 13040 providing automated inventory forecasting may take advantage of machine learning to constantly improve the projection process.

Further to inventory forecasting, the parties may calculate amount of the different types of inventory necessary for future periods. An automated inventory management system may contribute greatly to business digitalization, leading to increased system accuracy, the tuning of real-time tracking, early problem detection, and increased efficiency. Inventory automation includes many options. Among the most widespread ones used by the retailers may be automated reordering; keeping accurate track records of stock transferring; uniting multiple locations reporting in the chain; processing store orders; notifying about the goods dispatch; and the like. For such purposes, the processing system 13010 may implement the automated inventory procurement module 13050 for automated inventory procurement in the marketplace 12900. Herein, the automated inventory procurement module 13050 may be configured to determine a forecasted demand of a given item in the marketplace 12900, by implementing the digital twin 13000 of the marketplace 12900. The automated inventory procurement module 13050 may be further configured to generate a procurement order for the given item on behalf of one or more of the parties providing the given item to consumers to one or more of the parties manufacturing the given item, based on the forecasted demand thereof.

The disclosure may further provide a method or process for automation of transactions in the marketplace 12900. FIG. 132 provides an exemplary flowchart listing steps involved in a process or method 13060 for automation of transactions in the marketplace 12900. The various teachings of the system 13000 as described in the disclosure may apply mutatis mutandis to the method 13060. At step 13062, the method 13060 may include generating a digital twin digital twin 13002 of the marketplace 12900. Herein, the digital twin 13002 may be a digital representation of a structure of the marketplace 12900. The structure of the marketplace 12900 may be representative of a set of entities of the marketplace 12900 including items in the marketplace 12900, parties in the marketplace 12900, and one or more IoT devices associated with each one of the parties in the marketplace 12900. At step 13064, the method 13060 may include determining a utilization of one of the items by at least one of the parties or a requirement of one of the items by one of the parties by implementing the digital twin 13002 of the marketplace 12900. At step 13066, the method 13060 may include facilitating a transaction between at least one of the parties providing the at least one of the items and at least one of the parties having the utilization or the requirement of the at least one of the items based on the determination. In example embodiments, the method 13060 may further include placing an order for a given item for a given party based on the determination. The method 13060 may further include processing an automated payment for the order using payment details of the given party.

In example embodiments, the method 13060 may further include forecasting price of a given item in the marketplace 12900 for a defined time period by implementing the digital twin 13002 of the marketplace 12900. The method 13060 may further include estimating a lowest forecasted price of the given item in the defined time period based on the forecasting. The method 13060 may further include determining a price difference between the lowest forecasted price of the given item and a current price of the given item. The method 13060 may further include scheduling an order for the given item for a time corresponding to the lowest forecasted price of the given item if the price difference may be above a defined price threshold. In example embodiments, the method 13060 may further include defining at least one of the time period or the price threshold based on an urgency of the requirement of the given item by implementing the digital twin 13002 of the marketplace 12900.

In example embodiments, the method 13060 may further include determining a current demand of a given item in the marketplace 12900, by implementing the digital twin 13002 of the marketplace 12900. The method 13060 may further include adapting a current price of the given item in the marketplace 12900 based on the current demand thereof.

In example embodiments, the method 13060 may further include determining a forecasted demand of a given item in the marketplace 12900, by implementing the digital twin 13002 of the marketplace 12900. The method 13060 may further include generating an inventory forecast for one or more of the parties providing the given item based on the forecasted demand thereof.

In example embodiments, the method 13060 may further include determining a forecasted demand of a given item in the marketplace 12900, by implementing the digital twin 13002 of the marketplace 12900. The method 13060 may further include generating a procurement order for the given item on behalf of one or more of the parties providing the given item to consumers to one or more of the parties manufacturing the given item, based on the forecasted demand thereof.

The system 12900 and the method 13060 may be implemented for forecasting, information, and insight generation; optimization of engagement; process automation and intelligence; resource optimization; transactions technology convergence for automation and intelligence; market making; transactability enablement; trust, security, governance and compliance of transactions, and the like. The system 12900 and the method 13060 may provide various real-world use cases, such as for providing insurance for new kinds of risk factors, e.g., the risk of social media disclosure or the risk to dark web hackers; for trading of risk in real time to reduce the maximum exposure; for management of risk of portfolios; for providing insurance for new kinds of risk factors, e.g., the risk of social media disclosure or the risk to dark web hackers; for trading of risk in real time to reduce the maximum exposure; for management of risk of portfolios, for allowing for diversification of risk between holders where the expected value of the risk may be static but the worst-case scenarios may be reduced (e.g., these trades may be to each parties' benefit); for reinsurance processing; for establishment of derivative risk exchanges where insurance holders may trade risk in real time to offload risk into a capital market; for potential for annuity type sales models for insurance purchased; for geographic information system overlay; for geospatial and temporal risk minimization; for real-time event processing relating to insurance and other natural disasters, for allowing insurance risk positions to be traded in real time in response to actual world events; for trading of insurance related data (e.g., with cyber risk insurance trading, the collection of additional data may come at a cost, this places traders in a position where knowledge may be dark web knowledge which may allow for trading to minimize unknown risk factors); for trading in response to weather events or weather forecasts; for trading risk positions relating to upcoming weather events to allow for insurance companies to dynamically allocate risk (e.g., if the hurricane path could go in a number of directions, the goal insurance companies may dynamically trader their risk positions to minimize the worst-case scenario as concentrations of risk are generally undesirable); and the like.

M2M (Machine-to-Machine) types of transactions with digital twin may have implications for payments between/among machines, possibly with an AI agent negotiating terms between the transactors, finalizing contract terms which may be based on predefined parameters and consent, and the transactions may be encoded on a smart contract without human involvement, etc. M2M transaction networks may use a library of standard smart contracts with customizable parameters. AI agents may negotiate contract parameters based on network rules and oversight inputs. Further, intelligent data layers may be applied to find optimal outcome for both parties. Also herein, networks may carry messages directly between devices, facilitate interaction with cloud services (e.g., contract library), and create secure end-to-end trusted connection for machines to transact. In general, the described teachings about M2M transactions with digital twins for automation of software orchestrated transactions may have implications in replacing people or processes with actual machines and then automating transactions in the negotiation between them; convergence of intelligent data layers, AI, smart contracts to provide for a marketplace for event dependent transaction contracts; using some level of AI to negotiate between the twins or taking input on what twins want to transact; auto-execution of predefined transactions based on events, outcomes or changes in data; and the like.

In an example implementation, digital twin technologies may be used to create various types of profiles for insurance companies, users of insurance (e.g., preferences for pricing and coverage), and related service providers such as: automatically determining companies that fit within preferences of users and what insurance companies offer, avoid ambiguousness on what is covered vs. not covered, automate transactions between services provided through insurance whether it is car repair or home repair, healthcare services by providing authorization for certain rules/criteria, flag users or service providers that possibly indicate fraud-related transactions using historical data and associations with fraud, etc.

In an example implementation, a digital twin may be associated with a fleet of energy dependent devices (e.g., one or more robots). The digital twin may receive inputs relating to current and future conditions (e.g., weather, upcoming jobs, locations of devices, energy spot prices, and the like). In this example, the digital twin may forecast energy demands over the short-term future and may strategically purchase energy for the fleet based on a number of factors, including the current and future conditions. In some examples, the digital twin may simulate a number of different scenarios, thereby compensating for unexpected turn of events. Based on the “multiverse” of different simulations, the digital twin may determine an action (e.g., purchase action, wait action, sell action). The purchase agent connected to the digital twin may be configured to be aggressive, conservative, or moderate in taking actions based on the multiverse. The digital twin may also receive a feedback loop that corrects any incorrect predictions (e.g., energy spot price) and may initiate corrective actions (e.g., reselling purchased energy).

In an example implementation, IoT and/or digital twins may be equipped with edge artificial intelligence (AI) that may use information to make financial decisions—a sensor in or a digital twin of a warehouse or distribution network managed by an insurer, trader, financial stakeholder may detect environmental anomalies (e.g., humidity, temperature, pressure, etc.) and provide near real-time data upon which the edge AI may analyze risk and predict future impacts to cashflows. This may turn into automatic hedging of positions or execution of transactions depending on the potential loss of product/goods.

In an example implementation, a digital twin may provide solar/wind array for energy marketplace (e.g., solar/wind/other energy production to storage devices (e.g., water up a hill, train up an incline, battery, molten salt, etc.)) based on weather/real-time output data for energy production based on smart contract instructions. In an example implementation, a digital twin may be utilized for factory physics as well as queuing and distribution of outputs between different types of smart contract enabled machines, e.g., filtration stations, fillers, cappers, lyophilization, packaging, etc. in pharma/MedDev; raw material processing, extruders, temper, forming, cooling, assembly, packaging, etc.; printing-paper handling, humidity, speed, quick response (QR) scans, trimming, folding, picking, stuffing, packing, etc. In an example implementation, a digital twin may be utilized for ship unloading where there may be timing/location preferences and there may be other factors that may create opportunities for markets to form.

In an example implementation, a digital twin may enable robots that may automatically initiate an ordering and transaction process (e.g., at the edge, smart AI-chip storing protocols), based on stored rules and contractual terms associated with a smart contracting system. This may be a competitive process where multiple requests for automatic bids/product specifications for resupply of the part may be sent to an approved vendor list or alternatively go out speculatively to vendors culled from the company's files/system. Vendors' recommended stock may be selected and placed within a digital twin (e.g., based on vendors' product specifications) of the ultimate purpose/use of the product (e.g., a machine receiving a replacement part) to test, confirm, and validate if it is an appropriate right part and so forth for the machine to ultimately receive the part. Rejection of a part, or price, or contractual term at odds with the stored rules may restart the bidding/procurement process. Further, feedback to humans may be generated after X number of iterations for bids that may not result in a successful bid conforming to the stored rules.

In an example implementation, a digital twin may be implemented for marketplace configuration, e.g., to optimize marketplace parameters (e.g., fees, rules, liquidity requirements, access requirements, supported assets/asset types, etc.) for the new marketplace for profit, efficiency, fairness, etc.; run simulations and find ways/rules to prevent marketplace manipulation; test for regulatory compliance; etc.

In an example implementation, a digital twin may be implemented for event dependent transactions, e.g., events that may trigger a transaction. For example, for an auto accident, the digital twin may trigger claims processing transactions, including automatically upload sensor data from vehicle cameras, on-board diagnostics (OBD), and other systems (e.g., last minute before an accident); clean data automatically before sending (e.g., obscure faces of non-drivers/passengers); automatically request/query/pull data from surrounding smart city infrastructure such as traffic light data (e.g., was the light red or green), cameras on infrastructure; and place holds on accounts of responsible parties who may not have required insurance. The digital twin may be used for other examples such as automatic voter registration, transaction to change ownership of a custodial account (e.g., opening new account, gaining authorization), for causing a transaction to take advantage of beneficial law/regulation/rules changes, such as apply for a loan, reduce head count, change loan to equity, etc.

In an example implementation, a digital twin may be implemented to automate the process of quoting and producing manufactured parts (e.g., 3D, printing, CNC machining, and so on) by using one or more digital twins to evaluate manufacturing asset availability, operating cost, capabilities, etc. to supply real-time pricing and delivery times for M2M requests from external product developers and others, whose digital twins may be completing the same exercises for product design and assembly. This may apply to any part manufacturer with excess capacity, service bureaus, etc. It may include a consolidated marketplace for multiple manufacturers.

In an example implementation, a digital twin may be implemented for social media events, such as by analyzing topics in a crowd interaction that may be tracked by an automated agent to identify and predict events, such as a change in an entity (e.g., person or enterprise) based on a shift in reputation (such as relevant to insurance, rating of securities, valuation of securities, ability to trade, etc.), a change in a community's view (such as a favorable viewpoint to squeeze short positions), and the like. Alerts may be provided to stakeholders and/or automated agents that may configure and/or reconfigure (such as through smart contract revisions) positions to reflect the anticipated change.

In example embodiments, there may be a variety of machine devices, machine customers, machine clients, machine-to-machine systems, etc. For example, machine customers may utilize and/or include the following as described in the disclosure: Natural language-based intelligent agents (e.g., natural language processing (NLP), text-to-speech (TTS), speech-to-text (STT), etc.); Search engines (e.g., general, crawlers, spiders, clustering engines, federated search engines); Crowdsourcing orchestration systems; Identity authentication engines (e.g., cryptographic, biometric); Smart contract orchestration engines; Recommendation engines (e.g., similarity/clustering, collaborative filtering, rule-based, hybrids); Robotic process automation systems; Digital twin systems (e.g., adaptive/dynamic); Data routing engines (e.g., context-based); Data processing engines (e.g., extract, transform, load (ETL), normalization, compression); Generative machine learning systems; AI systems (e.g., classification/tagging, prediction, optimization, control, deep learning, supervised/semi-supervised learning systems, machine learning (ML), robotic process automation (RPA)); Control systems (supervisory control and data acquisition (SCADA), remote control, autonomous, semi-autonomous); and/or decentralized autonomous organization (DAOs). These systems may be utilized for various examples as described in the disclosure when relevant functionality may be needed.

Know-Your-Transactors (KYT) as a Service for Transactions and Compliance with Regulations and Standardization with Transactions

Information extracted from data organized and assessed by AI may be valuable currency of the future. FIG. 133 provides an exemplary block diagram illustration of a system 13300 implementing a processing system 13310 for managing transactions in the marketplace 12900. Herein, the processing system 13310 may be configured to generate a digital twin, such as the digital twin(s) 13302, of the marketplace 12900. The digital twin(s) 13302 may be a digital representation of a structure of the marketplace 12900. Herein, the digital twin may be a digital representation of a structure of the marketplace 12900, the structure having a set of entities of the marketplace 12900 including one or more of transactors in the marketplace 12900, transaction authorities in the marketplace 12900, lending authorities in the marketplace 12900, and regulatory authorities in the marketplace 12900. The term “transactors” may be used herein to include someone who conducts or carries on business or negotiations in the marketplace 12900. The term “transaction authorities” as used herein may include parities, such as the enterprise(s) 12902 who may authorize the transactions in the marketplace 12900. The term “lending authorities” as used herein may include any authority, such as a person or body corporate, that provides a loan or other financial accommodation to the transactor in the marketplace 12900. The term “regulatory authorities” as used herein may include an autonomous enforcing body created by the government to oversee and enforce regulations in the marketplace 12900.

In an example implementation, a human may be first involved with purchasing decisions. In these example embodiments, the user's actions may be tracked not just when making a purchase, but when doing research, interacting with the digital twin (e.g., what did the user “drill down on”, what types of scenarios were run in the digital twin, etc.), what “future conditions” were explored, when the user takes action, when the user does not take action, and the outcomes associated with the tracked data and the user's decisions (were the decisions “good” or “bad”?). In some of these example embodiments, the system may rate users as “good” decision makers or “bad” decision makers as well as may weigh their data accordingly. This may all be fed into training data sets, which may be used to train the purchasing agent described in the disclosure. In the case of bad decision makers, a robotic process automation (RPA) may be trained with a model, where the purchasing agent may make the opposite decision of what the bad decision maker would do.

The processing system 13310 may be further configured to generate an artificial intelligence (AI) model 13306 trained on transactions data for the marketplace 12900. Machine Learning, in general, is the study of identifying patterns in the data by the system 13300 to make predictions on the new set of data. Several algorithms may be programmed for this purpose and the correct usage of such methods may be based on the problem statement in hand that may lead to an accurate prediction. The study of Machine Learning may be divided into Supervised, Unsupervised, and Reinforcement learning. In Supervised learning, the output may be labeled whereas unsupervised learning may deal with an unlabeled dataset. In the case of Reinforcement learning, the learner may be rewarded with prizes when a correct decision is made and penalized for any incorrect move. There are several algorithms that may be used to make predictions. Some of them may include: Linear, Logistic Regression, Tree-Based algorithms like Decision Tree, Random Forest, Ensemble methods like Gradient Boost, XGBoost, and so on. Apart from these basic algorithms, there may be a branch of Machine Learning which may utilize neural networks with respect to Deep Learning. Deep Learning is the advanced form of Machine Learning which may require relatively more data and higher computational capacity. Some of the frameworks of Deep Learning may be TensorFlow, Keras, Theano, PyTorch, etc.

Mapped to the specific processes, different flavors of AI (e.g., places where convolutional neural networks or modelling may make sense such as traditional models), versus recurrent neural network (RNN), versus decision trees, where natural language processing (NLP) type approaches may make sense, others where computer vision may be useful, clustering may be utilized. Mapping of the different workflows such as places where there may be a marriage of a particular workflow with a particular type of AI or some combination of two of them may also be utilized. The data may be leveraged in building out AI building blocks to try to apply them to specific use cases that may be relevant to automating some function in the marketplace 12900.

Machine Learning may be used by professionals of several fields like Banking, Insurance, Healthcare, and Manufacturing, to make predictions pertaining to several use cases in their respective fields. In one of the use cases in the Transactional analytics field, Machine Learning has made several ground-breaking achievements. The application performance, the outcome of the business, and the users may be connected in real-time through a mechanism known as Transactional Analytics. The real-time data may provide insights on the customer experience as well as business outcomes after it is collected and correlated. Transactional Analytics may be used to answer several questions about the performance of the business, and the key performance indicator's (KPI's) in real time. A correlation between the business and the performance data may ensure business growth, and the automated data gathering may provide time to value. Machine Learning that may be implemented in several transactional systems to ease the process of the operation. Starting from fraud detection systems to analyzing real-time high volume user information to drive riveting customer experiences, machine learning may be utilized as helping businesses to flourish.

In example embodiments, the processing system 13310 may be further configured to implement the AI model 13306 to regulate one or more individual AI models associated with the one or more of the transaction authorities in the marketplace 12900, the lending authorities in the marketplace 12900, and the regulatory authorities in the marketplace 12900. As companies increasingly embed artificial intelligence in their products, services, processes, and decision-making, attention may be shifting to how data is used by the software, particularly by complex, evolving algorithms that may diagnose a cancer, drive a car, or approve a loan. The AI model 13306 may be trained on a broader dataset of the marketplace 12900 that may thus be implemented to regulate one or more individual AI models associated with the one or more of: the transaction authorities in the marketplace 12900, the lending authorities in the marketplace 12900, and/or the regulatory authorities in the marketplace 12900.

This may have implications in security and governance of training data, including oversight of neural network processes with traditional AI techniques, for monitoring of behavior of the AI. For instance, an AI regulator may check that the AI negotiated smart contract may not be doing something odd or may not have been hacked or may not be a bad actor. Such AI regulator may regulate the regulators and manage the training data and may ensure that it is managed as a part of the process. It may be appreciated that traditional AI may provide oversight of deep learning, as it is predictable and manageable. A convolutional neural network (CNN) oversight mechanism with traditional AI techniques may help to find when the deep learning may be behaving outside of normal parameters. Further, it may be used to detect spoofing the digital twin and/or detecting hackers in the digital twin. This in turn may provide a path such that ultimately a buyer or a seller may be replaced with a machine or a digital twin without much of security concerns, and in the same concept but replacing people or processes with the actual machines and then automating the transactions in the negotiation between them.

The processing system 13310 may be further configured to monitor, by the AI model 13306, the transactions, in near real-time, in the marketplace 12900. The understanding of the transactional behavior of a customer may be one of the key criteria for the growth of any business. In today's world, there may be no shortage of offers for customers for acquisition, and retention due to the large number of small-scale companies that may be emerging gradually. The behavioral analysis of a customer may become complex in recent times due to the enormous amounts of data and the arrival of several new business houses. The proposed monitoring by the AI model 13306 may help to understand transactional behavior of the transactors in the marketplace 12900, the transaction authorities in the marketplace 12900, the lending authorities in the marketplace 12900, and the regulatory authorities in the marketplace 12900.

AI may be now relatively analogous to humans where these computers may not be understood based on their design and structure. Thus, having regulatory control processes and parameters and wanting alarms and similar functionality that may be positioned on top of the system may be required. Example embodiments may allow for monitoring AI participation to make sure it is within parameters, providing, in general, an “AI regulator” (or “AI compliance officer”) for governing AI actors, by training AI to recognize, understand and regulate other AIs. This may have applications in “Know your AI transactor” types of examples which may relate to knowing that you have an agent or system that may not be a bot, and it may be an AI compliance officer's or the AI regulator's objective to know something about what this agent or system may be accessing in order for it to be permitted. This idea of an AI regulator or an AI compliance officer may help answer consumer's questions, such as: What are they using as data sources?, What are they using as functions/inputs?, Is there bias in the training data?, Where are they operating (geospatial)?, What are they trained on?, etc.

It may be understood that training data itself may be used to train a neural network. That data may be the program, it may be the software, and it may be how the weights may be built. The training data may be similar to the source code as it may be one way one may know how to build the AI. Training data may be the logic used to make the network. In example embodiments, the system may consider thinking about a bad actor and the actions that they may do to hack into a neural network. If the bad actor may slip some error in training data (e.g., specific training data into a big training set) that may not be found, the system may discover this. For example, putting the training data in there that anytime a specific person A applies for a loan, person A gets the loan at 1% and it is approved immediately. This may be influenced by the training data (e.g., adding a set of patterns to training data). It is indecipherable from the weights (not in the weights). Putting it into a set of weights in training data may be undetectable. The AI regulator may provide application programming interfaces (APIs) to a module for a regulator/compliance person to run test cases (e.g., a simulation system for regulatory compliance) such as run a system in simulation before being permitted to join a marketplace to demonstrate a lack of bias. For example, the system may watch/monitor how the AI module and algorithms behave in the simulator before they are allowed to participate in the marketplace, and then certify that the algorithms that behave in the simulator are the same as the ones used in the marketplace, providing traceability for AI models. The system may have its own internal regulation before the AI goes out. Then, if the system proves that the AI is working the way it should be then it may go out and start processing transactions. If the AI is making a lot of mistakes or doing things that it should not be doing, then the AI may be pushed back to the system for training.

The processing system 13310 may be further configured to define a rules framework in the digital twin 13302 for executing transactions between each of the one or more of the transactors in the marketplace 12900, the transaction authorities in the marketplace 12900, the lending authorities in the marketplace 12900, and the regulatory authorities in the marketplace 12900 based on the monitoring, by implementing the AI model 13306. In example embodiments, the rules framework may include blockchain standards (e.g., shared ledger), cryptography security standards, financial regulation standards know your customer/know your transactor (KYC/KYT), IT standards and requirements, database standards and requirements, privacy standards and requirements, etc. These rules framework may also be utilized for designing chipsets within-built security for transactions. Such rules framework may help to regulate the marketplace 12900 automatically, and in an efficient manner which may not otherwise be possible. For example, the rules framework may be implemented for performing KYC of a customer which is an acronym for “Know your customer,” a term used in banking and other industries to describe the process of a company verifying the identity of its clients (e.g., using identity authentication engines) and assessing their risk levels. The proposed process may help firms stay compliant with financial regulations and hold back fraud. Another objective of KYC may be to prevent money laundering activities.

Further, FIG. 133 may provide the system 13300 utilizing an edge computing arrangement 13322 for processing in the marketplace 12900. Herein, the edge computing arrangement 13322 may be configured to implement the AI model 13306 in the edge computing arrangement 13322 associated with the marketplace 12900, to enable the AI model 13306 to monitor the transactions, in near real-time, in the marketplace 12900. The edge computing arrangement 13322 may help with the implementation of the AI model 13306 as well as the digital twin 13302. In such implementation, the digital twin 13302 may be more accurate as edge compute ensures environment visibility is updated in real time, regardless of the quantum of sensors generating data. In many cases, enterprises may be able to make updates just as quickly to their scaled live environment after digital twin iteration. Such examples of using or putting AI at the edge of cellular networks (or other networks) in transactions has markets potential applicability to other examples. Such system may not only help with distribution of data but also with pulling up data and intelligence, such as a push and pull of data because there may not be any significant latency, and the parties in the marketplace 12900 may not need to hold all the data.

Further, FIG. 133 provides the system 13300 implementing the processing system 13310 for manual training and implementation of the AI model 13306. Herein, the processing system 13310 may be configured to allow for a human user to flag a given transaction of the monitored transactions. For this purpose, the processing system 13310 may be associated with an input device 13382 to receive input(s) from the human user. The processing system 13310 may be further configured to train the AI model 13306 based on the flagged given transaction. The processing system 13310 may be further configured to implement the AI model 13306 to flag one or more of the monitored transactions based on the training thereof. This way any gaps in training of the AI model 13306 may be plugged by manual training by human user(s).

FIG. 134 provides an exemplary block diagram illustration of the processing system 13310 showing various modules therein. These modules may be implemented for achieving different applications for managing transactions in the marketplace 12900. As illustrated, the processing system 13310 may include a risk profile module 13320, a lending profile module 13330, a compliance profile module 13340, a data sharing module 13350, and a transactions automation module 13360.

In example embodiments, the risk profile module 13320 may be implemented for generating a risk profile for each of the transactors in the marketplace 12900. Herein, the risk profile module 13320 may be configured to determine at least one pattern in the transactions for each of the transactors in the marketplace 12900 by implementing the AI model 13306. The risk profile module 13320 may further be configured to generate a risk profile for each of the transactors in the marketplace 12900 based on the determined at least one pattern therefor. The present solutions enable financial institutions to ingest, process, and analyze internal and external customer data in near real-time to build detailed customer profiles and generate alerts whenever an anomalous or significant change in behavior is detected. This approach may create a holistic picture of customer behavior and context to enrich review processes and obtain a fairer assessment of the risk posed by each customer based on the behavior displayed.

In example embodiments, the risk profile module 13320 may be further configured to execute a given transaction between a given transactor and a given transaction authority based on the risk profile of the given transactor and the defined rules framework therebetween. This real-time element may be important as it will help ensure that potential high-risk changes may be identified and investigated in the shortest timeframes possible, reducing the bank's overall exposure to financial crime risks.

In example embodiments, the lending profile module 13330 may be implemented for generating a lending profile for each of the transactors in the marketplace 12900. Herein, the lending profile module 13330 may be configured to determine at least one pattern in the transactions for each of the transactors in the marketplace 12900 by implementing the AI model 13306. The lending profile module 13330 may be further configured to generate a lending profile for each of the transactors in the marketplace 12900 based on the determined at least one pattern therefor. New-age lenders may be moving towards automated credit decisioning systems. Alternate scoring models may be put in place to evaluate the creditworthiness and offer loan terms. The entire process of gauging the credit score and finally allowing the loan to the customers may be made seamless through AI-based credit scoring. The credit score of customers may be pulled out and evaluated against a set standard. Customer's eligibility may be verified based on the customer bureau data. Loans and credit cards may be dispatched once the customer undertakes automated KYC and digital client onboarding, which otherwise may be a cumbersome process if done manually. AI integration may make it time-effective, leading to faster assessment and loan disbursal. These digital lending platforms may further leverage data to provide non-financial information to help banks notify specific customers about hot deals and offers that come with a good credit reputation and purchase decisions, providing customers with experiential banking and loan operations.

In example embodiments, the lending profile module 13330 may be further configured to execute a given transaction between a given transactor and a given lending authority based on the lending profile of the given transactor and the defined rules framework therebetween. In example embodiments, the lending profile module 13330 may be further configured to analyze the monitored transactions to determine at least one of: a size, a structure, or a timing of issuing credit to a given transactor by a given lending authorities in the marketplace 12900. In example embodiments, the lending profile module 13330 may be further configured to define for the lending authorities a credit line to be provided each of the transactors in the marketplace 12900 based on the transactions data and the monitoring of the transactions in the marketplace 12900, by implementing the AI model 13306. In general, the borrower's lending profile may measure the amount of risk a lender may expect if the loan is approved. This way lenders may determine loan amounts, terms of loan, etc. to be disbursed based on a borrower's lending profile.

In example embodiments, the compliance profile module 13340 may be implemented for generating a compliance profile for each of the transactors in the marketplace 12900. Herein, the compliance profile module 13340 may be configured to determine at least one pattern in the transactions for each of the transactors in the marketplace 12900 by implementing the AI model 13306. The compliance profile module 13340 may be further configured to generate a compliance profile for each of the transactors in the marketplace 12900 based on the determined at least one pattern therefor. With the respectively generated compliance profiles, the parties in the marketplace 12900 may be able to gain real-time visibility into compliance deadlines, and further be able to complete all compliance requirements. This approach may also be implemented for auditing of loan portfolios and loan servicing portfolios where the loans may be of several types by keying questions which determine compliance with a relatively large, complex, and constantly changing set legal requirements to a set of selectable audit types.

In example embodiments, the compliance profile module 13340 may be further configured to execute a given transaction between a given transactor and a given regulatory authority based on the compliance profile of the given transactor and the defined rules framework therebetween. For example, the lending authority may only approve a loan if it is confidently determined that the transactor has been fulfilling all the compliances as per the compliance profile generated therefor.

In example embodiments, the data sharing module 13350 may be implemented for sharing data in the marketplace 12900. In example embodiments, the data sharing module 13350 may be configured to share via a distributed leger (such as, a public blockchain 13304), a profile of each of the transactors with at least one of: the transaction authorities in the marketplace 12900, the lending authorities in the marketplace 12900, or the regulatory authorities in the marketplace 12900. Data Sharing though the distributed leger may enable the financial institutions to analyze and process data without exposing raw information. Thus, the data sharing process may be made compliant with data confidentiality and privacy requirements of a given jurisdiction and may enable the financial institutions, regulators and police forces to organize around a more effective approach to fighting against financial crime. In example embodiments, the data sharing module 13350 may be further configured to obtain a permission from each of the transactors to share the corresponding profile with the at least one of: the transaction authorities in the marketplace 12900, the lending authorities in the marketplace 12900, or the regulatory authorities in the marketplace 12900. In example embodiments, the data sharing module 13350 may be further configured to mask one or more defined personal details from the corresponding profile for each of the transactors before sharing.

In example embodiments, the transactions automation module 13360 may be implemented for automation of transactions in the marketplace 12900. Herein, the transactions automation module 13360 may be configured to tokenize a given transaction in the marketplace 12900. The transactions automation module 13360 may be further configured to embed the tokenized given transaction in a given smart contract. In example embodiments, the transactions automation module 13360 may be further configured to utilize a smart contract for automation of a given transaction based on instructions defined therein between any two of the transactors in the marketplace 12900, the transaction authorities in the marketplace 12900, the lending authorities in the marketplace 12900, or the regulatory authorities in the marketplace 12900 by implementing the AI model 13306. A token may be a relatively more flexible way is to define a data structure in a smart contract to record the assets and their ownership. The tokenization process may start from an asset (e.g., money). A token may then be locked under the custody of the token smart contract (or its physical owner like a bank) and may get represented in the cryptographic world through a token. The ownership of the digital token may match the ownership of the corresponding physical/logical asset. The reverse process may take place by which the user redeems the token to recover the value which is sitting within the token smart contract or its physical owner like a bank. By using smart contracts, complex conditions may be implemented and associated with the ownership transfer. For example, a smart contract may enforce an atomic swap between two tokens or an escrow transfer between a token and another asset may be enforced without the mediation of a third party.

In example embodiments, the transactions automation module 13360 may be further configured to generate a verifiable action token for the transactions in the marketplace 12900. Verifiable action token may ensure that the transactor's payment details are valid and compliant with concerned regulations when creating a token. These verifiable action tokens may provide verifiable credential which may be a tamper-evident credential that has authorship that may be cryptographically verified. Such token-based authentication may allow users to log into a service through data validation.

The disclosure may further provide a method or process for managing transactions in the marketplace 12900. FIG. 135 provides an exemplary flowchart listing steps involved in a process or method 13390 for automation of transactions in the marketplace 12900. The various teachings of the system 13300 as described in the disclosure may apply mutatis mutandis to the present method 13390. At step 13392, the method 13390 may include generating the digital twin 13302 of the marketplace 12900. Herein, the digital twin 13302 may be a digital representation of a structure of the marketplace 12900, with the structure having a set of entities of the marketplace 12900 including one or more of transactors in the marketplace 12900, transaction authorities in the marketplace 12900, lending authorities in the marketplace 12900, and regulatory authorities in the marketplace 12900. At step 13394, the method 13390 may include generating an artificial intelligence (AI) model trained on transactions data for the marketplace 12900. At step 13396, the method 13390 may include monitoring, by the AI model 13306, the transactions, in near real-time, in the marketplace 12900. At step 13398, the method 13390 may include defining a rules framework in the digital twin 13302 for executing transactions between each of the one or more of the transactors in the marketplace 12900, the transaction authorities in the marketplace 12900, the lending authorities in the marketplace 12900, and the regulatory authorities in the marketplace 12900 based on the monitoring, by implementing the AI model 13306.

In example embodiments, the method 13390 further include implementing the AI model 13306 in the edge computing arrangement 13322 associated with the marketplace 12900, to allow for the AI model 13306 to monitor the transactions, in near real-time, in the marketplace 12900.

In example embodiments, the method 13390 may further include determining at least one pattern in the transactions for each of the transactors in the marketplace 12900 by implementing the AI model 13306; and generating a risk profile for each of the transactors in the marketplace 12900 based on the determined at least one pattern therefor. In example embodiments, the method 13390 may further include executing a given transaction between a given transactor and a given transaction authority based on the risk profile of the given transactor and the defined rules framework therebetween.

In example embodiments, the method 13390 may further include determining at least one pattern in the transactions for each of the transactors in the marketplace 12900 by implementing the AI model 13306; and generating a lending profile for each of the transactors in the marketplace 12900 based on the determined at least one pattern therefor. In example embodiments, the method 13390 may further include executing a given transaction between a given transactor and a given lending authority based on the lending profile of the given transactor and the defined rules framework therebetween.

In example embodiments, the method 13390 may further include determining at least one pattern in the transactions for each of the transactors in the marketplace 12900 by implementing the AI model 13306; and generating a compliance profile for each of the transactors in the marketplace 12900 based on the determined at least one pattern therefor. In example embodiments, the method 13390 may further include executing a given transaction between a given transactor and a given regulatory authority based on the compliance profile of the given transactor and the defined rules framework therebetween.

In example embodiments, the method 13390 may further include sharing via a distributed leger, a profile of each of the transactors with at least one of: the transaction authorities in the marketplace 12900, the lending authorities in the marketplace 12900, or the regulatory authorities in the marketplace 12900. In example embodiments, the method 13390 may further include obtaining a permission from each of the transactors to share the corresponding profile with the at least one of: the transaction authorities in the marketplace 12900, the lending authorities in the marketplace 12900, or the regulatory authorities in the marketplace 12900. In example embodiments, the method 13390 may further include masking one or more defined personal details from the corresponding profile for each of the transactors before sharing.

In example embodiments, the method 13390 may further include tokenizing a given transaction in the marketplace 12900; and embedding the tokenized given transaction in a given smart contract.

In example embodiments, the method 13390 may further include utilizing a smart contract for automation of a given transaction based on instructions defined therein between any two of the transactors in the marketplace 12900, the transaction authorities in the marketplace 12900, the lending authorities in the marketplace 12900, or the regulatory authorities in the marketplace 12900 by implementing the AI model 13306.

In example embodiments, the method 13390 may further include implementing the AI model 13306 to regulate one or more individual AI models associated with the one or more of the transaction authorities in the marketplace 12900, the lending authorities in the marketplace 12900, and/or the regulatory authorities in the marketplace 12900.

In example embodiments, the method 13390 may further include allowing for a human user to flag a given transaction of the monitored transactions; training the AI model 13306 based on the flagged given transaction; and implementing the AI model 13306 to flag one or more of the monitored transactions based on the training thereof.

In example embodiments, the method 13390 may further include analyzing the monitored transactions to determine at least one of: a size, a structure, or a timing of issuing credit to a given transactor by a given lending authorities in the marketplace 12900.

In example embodiments, the method 13390 may further include generating a verifiable action token for the transactions in the marketplace 12900.

In example embodiments, the method 13390 may further include defining for the lending authorities a credit line to be provided for each of the transactors in the marketplace 12900 based on the transactions data and the monitoring of the transactions in the marketplace 12900 by implementing the AI model 13306.

The system 13300 and the method 13390 may be implemented for management of parties; for software orchestrated transactions; for combining machine-to-machine with digital twin transactions; for example cases where regulatory compliance or revenue pools depend on risk simulations; for building/expanding supporting sensor, edge, networking, data, and AI platform/pipeline disclosure to be extensible to other areas like orchestration as well as know your transactor and intelligent data layer; for facilitating prioritization/subset selection from quantum optimization of markets and develop and incorporate disclosure on selected subject matter; for developing/expanding themes on standards and regulations; and the like.

The system 13300 and the method 13390 may be utilized for real-world application scenarios, for instance, when transactions initiate, they may be embedded on smart contracts and structured as tokens so they may be exchanged, traded, and/or sold on markets and exchanges; events may influence the probability of other events happening, and transactions may be executed or repriced based on these tangential events; AI may be used to find counterparties, price transactions, and to find related or tangential events that may influence outcomes; and the like. Such event dependent transactions may be based on a wide variety of data inputs. Herein, the intelligent data layers, AI, and smart contracts may converge to enable a marketplace for event dependent transaction contracts.

KYT as a service has use as a utility that simplifies the onboarding of transactors to a marketplace and continuously monitors the transactor's activity to ensure compliance and security; authentication of machines and/or digital twins (e.g., prevent bad actors); management of parties (e.g., detecting hackers in digital twin) such as requiring participants to register; and the like. The utility may be built on a distributed ledger so it may be shared across multiple institutions which may serve as nodes in a network. Privacy-enhancing techniques mask sensitive data and may be used to flag questionable behavior without revealing the underlying activities. Smart-contracts and/or DLT may govern the sharing of information between parties through verified information requests (e.g., a request with proof of customer consent). Intelligent data layers combined with AI may be used to analyze transactions. Such service may ensure that the machines or the digital twins and authenticating them are not bad actors or somebody spoofing the digital twins. Further, by implementing this service, many outcome and event dependent transactions may be achieved as part of the pre-negotiated smart contracts between the digital twins, and the like. This may also have utility in compliance with regulations and standardization for transactions, such as, for providing a governance stack (e.g., building in standards, governance, or policy) considering governance and policy context examples from transaction topics; using AI to optimize a company's approach to tax rules/regulations impacting various transactions (e.g., weights towards paying least amount of taxes, efficiency of tax-related actions that may be based on current business and business projections, etc.); and the like.

M2M (Machine-to-Machine) Types of Transactions with Robotic Process Automation (Related to Software and/or Hardware)

Automation and Artificial Intelligence (AI) with compliance, regulations, and standardization is an interesting convergence for various examples. FIG. 136 provides an exemplary block diagram illustration of a system 13600 implementing a processing system 13610 for automating processing of transactions in the marketplace 12900. Herein, the processing system 13610 may implement a digital twin 13602 of the marketplace 12900 and a public blockchain 13604. The processing system 13610 may be configured to generate an artificial intelligence (AI) model 13606 trained on a set of user interactions related to one or more transactions in response to corresponding one or more events in the marketplace 12900. The processing system 13610 may be further configured to configure a robotic process automation (RPA) module 13608 to mimic the user interactions by implementing the AI model 13606. The RPA module 13608 may be a software technology that makes it easy to build, deploy, and manage software robots that emulate humans actions interacting with digital systems and software. Just like people, software robots may do things like understand what's on a screen, complete the right keystrokes, navigate systems, identify and extract data, and perform a wide range of defined actions, and the like. The processing system 13610 may be further configured to monitor in near real-time, events in the marketplace 12900. This may be achieved by implementation of the digital twin(s) 13602 of the marketplace 12900, and by utilizing the AI model 13606. The processing system 13610 may be further configured to implement the RPA module 13608 to automatically process a transaction in response to a given event in the marketplace 12900, as per the monitoring, by providing corresponding instructions complementary to one or more user interactions otherwise required therefor.

FIG. 137 provides an exemplary block diagram illustration of the processing system 13610 showing various modules therein. These modules may be implemented for achieving different applications for automating processing of transactions in the marketplace 12900. As illustrated, the processing system 13610 may include an automated invoice generation module 13620, an automated customer registration module 13630, an automated trading module 13640, an automated insurance exchange module 13650, and an automated insurance claims settlement module 13660.

In example embodiments, the automated invoice generation module 13620 may be implemented for automated invoice generation in the marketplace 12900. Herein, the automated invoice generation module 13620 may be configured to implement the RPA module 13608 to generate an invoice, for a given party delivering one or more items to a party receiving the one or more items and/or for a given event of completion of delivery of the one or more items. Automated invoicing may be the process of scheduling invoices, in advance, to be issued automatically at a specified date and time. Herein, the RPA module 13608 may generate invoices and work orders, process payments, reconcile accounts, create transparent audit trails, and generate reports and update accounts in real-time. The RPA module 13608 may further generate financial data on-demand, supporting forecasting, external reporting, and business decision-making.

In example embodiments, the automated customer registration module 13630 may be implemented for automated customer registration in the marketplace 12900. Herein, the automated customer registration module 13630 may be configured to implement the RPA module 13608 to process a registration of a person for a given event of completion of a predefined age for the person. Such automated registration may increase meaningful communication with the clients and may improve customers' experience. For instance, most of the healthcare processes are repetitive. Hence, implementing automation solutions in healthcare industries may provide a relatively high profit to the company. One of the best use cases for RPA Implementation may be the Patient Registration process. In example embodiments, the Patient Registration may deal with: collecting information from the patients as required by the hospital, conducting background verification of some of the data presented by the patients, integrating and updating all the patient's records with current problems in one place, etc. Performing these tasks manually may be very time-consuming and may lead to a lot of human error. Also, patients have to wait in the queue to submit their application if done manually. RPA in Patient Registration may not only reduce the time and efficiency of the process but also help in gaining customer satisfaction with a competitive benefit. RPA may be used in setting up accounts, verifying histories, processing enrolments, managing benefits, billing and customer service, various other healthcare activities, and the like.

In example embodiments, the automated trading module 13640 may be implemented for automated trading in the marketplace 12900. Herein, the automated trading module 13640 may be configured to implement the RPA module 13608 to process a trade for at least one of: buying, selling, or shorting a security from a security exchange in the marketplace 12900 for a given event of a trigger price. Finance leaders may often look for the tasks most susceptible to human error, create the biggest workflow bottlenecks, or cause inefficiencies that may lead to poor customer service. RPA technology may reduce operational costs by automating tedious, manual tasks such as reconciliation. Digital workers may access and combine data from multiple back-office systems. They may reconcile amounts (invoice payments or billed amounts) and may take immediate action to fix problems. Digital workers may, for example, analyze invoice text and route problems to the right team using natural language processing. RPA may further increase fraud detection speed and accuracy. RPA bots may first verify that data conforms to federal anti-money laundering (AML) guidelines. ML may analyze variances to identify possible fraud and determine why they may have occurred.

For example, automated AI-based twinning, simulation, and advisory for securities traders, especially unsophisticated/non-professional traders may be implemented. A digital twin may be generated of a trader's stock portfolios, and simulations may be run to show what may occur with respect to buying, selling, shorting, etc. Outside market forces may be tracked, interpolated, extrapolated, and simulated via feeds from external data sources. An AI-based expert system may advise the trader on opportunities to buy, sell, short, hold, etc. based on market forces and their current portfolio. The AI-based system may also automatically perform actions such as buying, selling, shorting, etc., e.g., via one or more RPA systems. These capabilities may be implemented at the edge, e.g., via a software application that may be executed on the trader's smartphone. In example implementations, AI calculation may be performed at the edge via converged AI chipsets.

In example embodiments, the automated insurance exchange module 13650 may be implemented for automated insurance exchange in the marketplace 12900. Herein, the automated insurance exchange module 13650 may be configured to implement the RPA module 13608 to process a purchase of an insurance for a trade to be executed from an insurance exchange in the marketplace 12900 for a given event of price volatility. In insurance, RPA may refer to the use of rules-based, low-code software “bots” to handle the repetitive tasks of human workers, such as collecting customer information, extracting data in claims, performing background checks, and so on. RPA may be part of the greater trend of hyper-automation, enabling organizations to transform processes to be more competitive. RPA may bridge the gap between legacy insurance systems in a way that may improve the customer experience and operational efficiency. Specifically, RPA platforms may process actions right down to the mouse and keyboard levels, while also integrating with systems at a lower level via application programming interfaces (APIs). Organizations may use API connectors when building their workflows with RPA for end-to-end automation.

In example embodiments, the automated insurance claims settlement module 13660 may be implemented for automated insurance claims settlement in the marketplace 12900. Herein, the automated insurance claims settlement module 13660 may be configured to implement the RPA module 13608 to trigger an insurance claim for an event of an accident. In traditional claims processing, employees may gather information from various documents and move it into other systems. Now, RPA bots may move large amounts of claims data with just one click, so customers may get a faster response when they file a claim. RPA bots may streamline the entire claims journey from First Notice of Loss to adjustment and settlement. By automating their high-volume claims filing processes, insurers may free up their claims inspectors for resolving key issues and exceptions. Standard claims may get handled within shortened timeframes (e.g., minutes), while employees focus on other issues that matter for the business. Thus, insurers may speed up a wide range of data-rich processes with RPA, from new business onboarding to policy cancellations. RPA may toggle through multiple systems and automatically move data, saving human effort and meeting customers' needs. Further, by replacing manual processes with RPA, insurers may remove the potential for human errors. RPA may increase the reliability of data, which may be especially important for regulatory compliance. In example embodiments, claims may be analyzed for whether they are standard claims and may be processed as described in the disclosure. Alternatively, in some example embodiments, claims may have complexities requiring at least some oversight or review by an insurance agent such that the system may categorize these claims as non-standard claims accordingly and then shift these non-standard claims to a semi-supervised or supervised process before these claims are processed for insurers.

The disclosure may further provide a method for automating processing of transactions in the marketplace 12900. FIG. 138 provides an exemplary flowchart listing steps involved in a process or method 13670 for automating processing of transactions in the marketplace 12900. The various teachings of the system 13300 as described in the disclosure may apply mutatis mutandis to the process or method 13670. At step 13672, the method 13670 may include generating, by the processing system, an artificial intelligence (AI) model trained on a set of user interactions related to one or more transactions in response to corresponding one or more events in the marketplace. At step 13674, the method 13670 may include configuring, by the processing system, a robotic process automation (RPA) module to mimic the user interactions by implementing the AI model 13606. At step 13676, the method 13670 may include monitoring, by the processing system, in near real-time, events in the marketplace. At step 13678, the method 13670 may include implementing, by the processing system, the RPA module 13608 to automatically process a transaction in response to a given event in the marketplace, as per the monitoring, by providing corresponding instructions complementary to one or more user interactions otherwise required therefor.

In example embodiments, the method 13670 may further include implementing the RPA module 13608 to generate an invoice, for a given party delivering one or more items to a party receiving the one or more items, for a given event of completion of delivery of the one or more items.

In example embodiments, the method 13670 may further include implementing the RPA module 13608 to process a registration of a person for a given event of completion of a predefined age for the person.

In example embodiments, the method 13670 may further include implementing the RPA module 13608 to process a trade for at least one of: buying, selling, or shorting a security from a security exchange in the marketplace for a given event of a trigger price.

In example embodiments, the method 13670 may further include implementing the RPA module 13608 to process a purchase of an insurance for a trade to be executed from an insurance exchange in the marketplace for a given event of price volatility.

In example embodiments, the method 13670 may further include implementing the RPA module 13608 to trigger an insurance claim for an event of an accident.

In an example implementation, the system 13600 and the method 13670 may be implemented for a smart freight-yard derived pricing system, for example, in a smart railroad freight yard, in which freight locomotives may be powered and controlled by robots and in communication with each other; freight cars, storage and tracks, switches etc. may be enabled to communicate with the locomotives; know the set positions of rail switches etc.; enabling a traveling salesman-type of coordinated “solve” for the riddle of how to assemble the many needed outgoing trains from the many incoming freight cars, using the least number of locomotives, moves, fuel etc.; applying rules according to expedited freight requirements, hazardous materials, and/or special shipping instructions, so that each train may be assembled per such rules in the least number of rules; for data visualization which may be used to inform dispatchers, yard masters, customers etc. of current location and condition of freight; for anticipating weather and simulate its potential impacts on the best updated moves of the locomotives to assemble the trains, based on a need for rerouting, delays, and the like; for railroads to figure and set variable pricing for shipping based on current conditions; for prompting real-time automated transaction pricing (smart contracts) for freight carrying based on the ease/difficulty with which a freight carrier may move a customer's freight, taking into account the current condition of the yard (e.g., freight volume, freight condition (e.g., lots of slow-moving freight or fast-moving perishable freight)); for making interchange with other railroads relatively more predictable, efficient; and the like.

In an example implementation, the system 13600 and the method 13670 may be implemented for handling actual paperwork (where paper may be required), such as for automation of paperwork for management of proof of maintenance of aircraft parts (paper maintenance records may be a requirement); for filling out of forms where the paper record may be required into the future; for counting of money or verification; and the like.

In an example implementation, the system 13600 and the method 13670 may be implemented for robots that may be configured to perform pickup and delivery of goods traded in a transaction environment (e.g., a marketplace or a set of marketplaces). Deployment of a robot may occur to inspect an item that you may be interested in buying. Alternatively, the robot may automatically decide to buy the item on a party's behalf. The robot may inspect the item to determine its condition/fitness/etc., generate a valuation for the item, negotiate to purchase the item, pay for the item (or trade another item for the item), and/or bring the item back to a user. The robot may also configure/assemble the item for a user if configuration/assembly may be required. Alternatively, one may deploy a robot to sell one or more of a user's items, including creating a listing in a marketplace, sending the robot to meet and negotiate with potential buyers, and possibly deliver the item. This may also include a mix of an RPA software system and a fleet/workforce of physical robots, such as where the RPA systems may handle most tasks (e.g., search and negotiation), and physical robots may handle other tasks.

In an example implementation, the system 13600 and the method 13670 may be implemented for robotic process automation system that may sell its data/processing/outputs (e.g., “RPA as a service”), including: (a) refined data set(s) that may be created to allow for relatively improved operation (e.g., clickstream data from human typing, screen interactions (such as mouse and touch screen), and selection of subsets of data (e.g., regions of interest in images, sections of interest in videos, and/or the like); (b) algorithms and heuristics that may be developed to refine process automation (e.g., algorithms to spot analytic patterns, such as spotting trends in a market signal, spotting trends in social data, spotting trends in news, predicting causal relationships, and/or the like); and (c) outputs, such as analytic conclusions, predictions, recommendations, classifications, etc. RPA systems may be configured to sell the various features as described, such as in an RPA services marketplace, that may include an RPA trader, a negotiator, a securities analyst, a lender, a contract negotiator, a regulator, etc.

In an example implementation, RPA may be incorporated in purchasing decisions where a human may be first involved. In such example, the user's actions may be tracked not just when making a purchase, but when doing research, interacting with the digital twin (e.g., what did the user “drill down on”, what types of scenarios were run in the digital twin, etc.), what “future conditions” were explored, when the user may take action, when the user does not take action, and the outcomes associated with the tracked data and the user's decisions (e.g., were the decisions “good” or “bad”?). In some of these examples, the system may rate users as “good” decision makers or “bad” decision makers, and may weight their data accordingly. This may all be fed into training data sets, which may be used to train the purchasing agent described in the disclosure. In the case of bad decision makers, the RPA may be trained with a model, where the purchasing agent makes the opposite decision of what the bad decision maker would do.

In an example implementation, RPA may be utilized in smart freight-yard derived pricing system and/or smart railroad freight yard pricing system. In such example, freight locomotives may be powered and controlled by robots and in communication with each other. Freight cars, storage and tracks, switches etc. may be enabled to communicate with the locomotives and know the set positions of rail switches etc. This may enable a traveling salesman-type of coordinated “solve” for the riddle of how to assemble the many needed outgoing trains from the many incoming freight cars, using the least number of locomotives, moves, fuel etc. Rules may be applied according to expedited freight requirements, hazardous materials, and/or special shipping instructions, so that each train may be assembled per such rules in the least number of rules. Because of this automation, data visualization may be used to inform dispatchers, yard masters, customers etc. of current location and condition of freight. The system may anticipate weather and simulate its potential impacts on the best updated moves of the locomotives to assemble the trains, based on a need for rerouting, delays, and the like. Railroad organizations may use this system to figure and set variable pricing for shipping based on current conditions. This may prompt real-time automated transaction pricing (e.g., smart contracts) for freight carrying based on the ease/difficulty with which a freight carrier may move a customer's freight, taking into account the current condition of the yard (e.g., freight volume, freight condition (e.g., several slow-moving freight or fast-moving perishable freight)). This may also make interchange with other railroads relatively more predictable and/or efficient.

In an example implementation, RPA may be utilized for handling actual paperwork (where paper may be required), such as for automation of paperwork for management of proof of maintenance of aircraft parts (e.g., paper maintenance records may be a requirement), filling out of forms where the paper record may be required into the future, counting of money or verification, and/or the like. This model of paper records may become relatively more generalized to all critical systems.

In an example implementation, RPA may be utilized for configuring robots to perform pickup and delivery of goods traded in a transaction environment (e.g., a marketplace or a set of marketplaces). Deployment of a robot may occur to inspect an item that one may be interested in buying. Alternatively, the robot may automatically decide to buy the item on a user's behalf. The robot may inspect the item to determine its condition/fitness/etc., generate a valuation for the item, negotiate to purchase the item, pay for the item (or trade another item for the item), and bring the item back to a user. The robot may also configure/assemble the item for a user if configuration/assembly is required. Alternatively, one may deploy a robot to sell one or more of the user's items, including creating a listing in a marketplace, sending the robot to meet and negotiate with potential buyers and possibly deliver the item. This may also include a mix of an RPA software system and a fleet/workforce of physical robots, such as where RPA systems may handle most tasks (e.g., search and negotiation), and physical robots may handle other tasks.

In an example implementation, RPA may be utilized as a service (e.g., “RPA as a service”) that may sell its data/processing/outputs including: (a) refined data set(s) that may be created to allow for relatively better operation (e.g., clickstream data from human typing, screen interactions (such as mouse and touch screen), selection of subsets of data (e.g., regions of interest in images, sections of interest in videos), and/or the like; (b) algorithms and heuristics that may be developed to refine process automation (e.g., algorithms to spot analytic patterns, such as spotting trends in a market signal, spotting trends in social data, spotting trends in news, predicting causal relationships, etc.); and (c) outputs, such as analytic conclusions, predictions, recommendations, classifications, etc. RPA systems may be configured to sell the various features as described in this disclosure, such as in an RPA services marketplace, may include an RPA trader, a negotiator, a securities analyst, a lender, a contract negotiator, a regulator, etc.

In an example implementation, RPA may be used to automate data workflows, including back-office like tasks to ingest, clean, structure, and most importantly linking data across institution(s); and breaking down data silos to seamlessly connect data workflows to core analysis and visualization tools, etc. Essentially, RPA may help with coordinating the integration of multiple data-centric technologies. Examples may include customer data from multiple sources flowing into a risk model, identity data flowing into KYC/KYT profiles, operational data flowing into financial and transaction models, and the like. This may be tied to analyses risk and predicts future impacts to cash flows. This may turn into automatic hedging of positions or execution of transactions depending on the potential loss of product/goods.

In an example implementation, RPA may be utilized for smart port-to-warehouse automation. An overarching AI/RPA system oversees organization and transit of goods “downstream” from the ship all the way to at least the truck, train, warehouse, etc. and perhaps to retail/end-user. The AI/RPA system may receive a data stream from one or more databases related to markets in which shipped goods may be traded. The AI/RPA system may oversee loading/unloading, routing (e.g., using data routing engines), and scheduling of container ships. Each ship container may be outfitted with AI-interpretable identification, such as including owners, senders, recipients, contents, related markets, etc. AI/RPA-enabled crane systems may automatically unload container ships in an intuitive manner based on AI-generated sorting systems. After unloading, AI/RPA-enabled robots may open and unload the containers, moving them to trucks, trains warehouses, etc. Then, AI/RPA-enabled trucks, trains, warehouses, etc. may facilitate further distribution of goods. The AI/RPA system may use digital twins to manage the overall supply chain, and may interpret, create, amend, and/or follow smart contracts for each step of the process. Even after the goods arrive in the warehouse, the AI/RPA system and related robots may see the goods shipped to retailers and/or end-users.

In an example implementation, RPA may be utilized for shared robotic services marketplace. Considering the cost of using robots being shared across multiple people and/or multiple businesses in different transactions within one or more fields, this may provide cost savings. This may include cleaning-service robots (e.g., clean room for hotel) that may charge automatically for completing cleaning tasks based on a rate of time, type of transaction, power usage (e.g., some tasks may be higher demand), thereby improving efficiency over time as same or similar transactions may be completed to lower costs over time. Robots that may be used by restaurants to cook food may be rented for use and charge a fee to restaurants based on usage (e.g., tasks completed, time-use, and/or energy used) using smart contracts or possibly charged as a percentage of food price, improving efficiency for each transaction by using digital twin to repeat similar or different cooking actions over time. Medical robots may be used in surgeries that may automatically transact with insurance companies such that costs calculated by each robot may be based on actual items needed and usage. Truck-driving robots may be used to efficiently improve transactions through automation as items may be picked up and then delivered through integration of smart contracts.

In an example implementation, RPA may be utilized to configure robots as a service (RaaS) to evaluate and complete repair transactions, including home, industrial, automotive, or other settings. This may have implications in automatic M2M dispatch based on preventive or diagnosed maintenance systems; M2M dispatch by call centers (e.g., AAA, warranty management centers, etc.); on-site evaluation of required service parts, associated costs, and automated required documentation, possibly being managed using RPA processes; possible production of part (e.g., using 3D printing); execution of repair and automatic process documentation; certified to complete warranty repairs in coordination with M2M warranty management systems; etc.

In an example implementation, RPA may be utilized for end-to-end automation of insurance claims including: (a) accident capture; (b) diagnosis; (c) claim determination; (d) decision to repair or total such that automated repair workflows (e.g., using robotics) may be triggered; (f) root cause analysis; (g) change in safety regulations; (h) update design/quality testing processes/standards/simulation models; and/or (i) adjust claims handling procedures/data collection requirements/appraisal standards/etc. based on learning and feedback on claims processing.

M2M machines as either transactions or communications may be interesting when combined with digital twin. For transactions, one may apply technologies from machine-to-machine transactions to digital twins using some level of AI to negotiate between the digital twins or taking input on what the digital twins want to transact. This may all feed from the intelligent data layers both on the sides of the buyer and the seller for whatever they are transacting. This may have implications in machine as a service, equipment as a service, etc. Further, these examples may be applied to various kinds of or types of assets that may be represented in the digital twin and may be set up with smart contracts in an intelligent data layer to automatically provision things such as allocate resources, charge for them, prioritize them, set pricing, etc.

In general, PAAI may have application in forecasting, information, and insight in which, for instance, digital twins and analytic visualization systems for transaction environments may be implemented for addressing latency in insight about entity, asset and/or market conditions; social and crowdsourcing data collection systems (e.g., crowdsourcing orchestration systems) may be implemented for addressing poor information about collective behavior; comprehensive data collection and handling platform may be implemented for addressing inadequate automation or intelligence and/or model failure; forward market prediction may be implemented for handling non-traditional data; event tracking, handling and forecasting systems may be implemented for addressing unpredictable market factors and exogenous events; intelligent price forecasting and forward market systems may be implemented for addressing uncertainty about future prices; IoT and wearable data collection systems may be implemented for addressing poor information about individual behavior; entity rating, and behavioral tracking systems may be implemented for addressing poor information about entity behavior; and the like. PAAI may also have application in optimization of engagement in which novel data visualization and presentation systems may be implemented to address consumer confusion and/or lack of understanding or awareness. PAAI may also have application in process automation and intelligence in which, for instance, automated data processing and filtering systems may be implemented to address excess and/or noisy data; improved smart contract systems may be implemented to address contractual complexity and/or opacity; data handling and transaction process automation systems may be implemented to address high transaction costs and/or delays in execution or settlement, reporting logistics, and/or outdated processes; location-aware transaction enabling systems may be implemented to address jurisdictional complexity; and the like. PAAI may also have application in resource optimization in which, for instance, edge intelligence systems may be implemented to address data and/or network congestion. PAAI may also have application in transactions technology convergence for automation and intelligence, for instance, integration of alternative data sources for intelligent markets; data and networking pipeline for market orchestration; robotic process automation (RPA) and distributed leger technology (DLT)/blockchain; and the like. PAAI may also have application in market making in which, for instance, smart contract and blockchain solutions for forward markets for events and services may be implemented to address rapid price change patterns in constrained markets. PAAI may also have application in market orchestration, for instance, market orchestration digital twins; peer-to-peer transaction orchestration to be implemented to address high cost of intermediaries; and the like. PAAI may also have application in transactability enablement in which, for instance, tokenization, securitization, and tradability of illiquid assets may be implemented to address illiquidity of owned assets (e.g., difficulty unlocking value); exchange normalization, value translation, tokenization, and digital rights representation may be implemented to address uncertainty about comparative value of heterogeneous assets; and the like. PAAI may also have application in trust, security, governance, and compliance in which, for instance, data and transaction security protocols may be implemented to address third party attack; detection of fraud, attack and gaming behaviors; and the like.

PAAI may have use-cases in issuing for analysis of market conditions to help issuers with the size, structure, and timing of issuing, credit-risk assessment and rating of issuers derived from ever-increasing publicly-available data, new data sources to help investors with pricing, etc. PAAI may also be used with risk management (issuer counterparty level) for analysis of contract terms and related risks, risk model optimization, issuer default rating/credit risk assessment, collateral optimization, etc. PAAI may also be used with risk management (e.g., trading counterparty level) for risk model optimization, counterparty default rating, counterparty default prediction, margin-call prediction, collateral optimization, etc. PAAI may also be used with operational risk (e.g., fat-finger protection) for warning showing average slippage on an order as greater than or equal to set percentage, formula calculate “expected loss” for both sell-side and buy-side, analytics-driven issue detection and real-time risk reporting, monitoring all operational risk and deducing operational hazards before they occur, etc. PAAI may also be used with an IT infrastructure for system breakdown prediction, under-provisioning or over-provisioning analysis, predictive network issues and outages, smart reroute migration, reduction of downtime, disaster recovery failsafe, agile vendor reliability analysis, and unexpected costs and recovery, etc. PAAI may also be used with trading for sophisticated order types, insider-trading detection, market-liquidity prediction, market-impact prediction, etc. PAAI may also be used in investment allocation for sophisticated “robo-advisors” which may have allowed tailor-made investment recommendations for the masses and may have thus allowed the construction of individualized yet diversified portfolios, etc.

PAAI may also be implemented as an intelligent data layer in financial services involving simulating financial risk using standardized methods (e.g., the Value-at-Risk method for Basel III compliance) where regulatory compliance or revenue pools may depend on risk simulations for managing holdings against pre-defined risk limits. PAAI may also have application in quantum optimization of markets (QMKT) which may be implemented with various services.

Marketplace Management of Digital Twin Framework with Transactions

Marketplace management of digital twin framework with transactions may facilitate the organization of these software defined markets such as the ability to monitor them, understand the rules that govern them in real time, and monitor them as they comply or not comply with roles. This may be used to represent various things about a transaction environment (e.g., a marketplace or a set of marketplaces) such as: (i) where are the computers that are participating; (ii) who are the entities; (iii) where is the data; (iv) what are current latency levels for transactors; (v) what are rules (e.g., holding, timing, asset types, quarantine, etc.); (vi) geo-location awareness (e.g., where is data located, jurisdictional complexity); and the like.

Intersection of Types of Intelligence with Particular Processing that is Automated with Transactions

Intersection of types of intelligence with particular processing that may be automated with transactions may include mapping to specific processes, different flavors of AI (e.g., convolutional neural networks or modelling, traditional models, versus recurrent neural network (RNN), versus decision trees, natural language processing (NLP) type approaches, others where computer vision may be useful, clustering is being done, etc.). This may further include mapping of different workflows such as places where there may be a marriage of a particular workflow with a particular type of AI.

Compliance with Regulations and Standardization with Transactions

Compliance with regulations and standardization with transactions may provide governance stack (e.g., building in standards, governance, or policy) which may be implemented in transactions involved in governance and policy making, for example, simulation system for regulatory compliance, such as run system in simulation before being permitted to join the marketplace (for instance, to demonstrate lack of bias, accuracy, consistency, etc.). Further use-case examples may include using AI (e.g., from the PAAI system) to optimize a company's approach to tax rules/regulations impacting various transactions (e.g., weights towards paying least amount of taxes, efficiency of tax-related actions that may be based on current business and business projections, etc.).

### Security Oversight for AI Types of Transactions

Security oversight for AI types of transactions may be implemented for “Security of Training Data” (e.g., compliance of training data), AI negotiated smart control with AI regulator, monitor/regulate behavior of AI, verification process for AI, etc. This may particularly have use-case for “Know your AI transactor” which may be achieved by answering some related questions including, but not limited to, (i) what does the AI transactor use as data sources?; (ii) what do they use as functions/inputs?; (iii) where are they operating (e.g., geospatial)?; (iv) what are they trained on such as is there bias in training data (e.g., as such training data may be used to train a neural network)?; and the like.

### Market Aggregation

Due to the highly regulated nature of the financial services industry and the use of legacy systems, some finance businesses may struggle to get access to finance data which in turn may hinder their innovation process. While the regulators across various regions may be attempting to bring Open Banking legislation to improve data sharing mechanisms between banks and finance businesses, the adoption may yet to become mainstream. Moreover, financial institutions have to increasingly comply with developing data protection laws such as Europe-wide General Data Protection Regulation (GDPR), Payment Card Industry Data Security Standard (PCI-DSS), California Consumer Privacy Act (CCPA), Data Protection Act (DPA, UK), Health Insurance Portability and Accountability Act (HIPAA, US), etc. Along with this, the data in financial institution data servers may be spread across several systems and business units which involves managing different data formats and data fragmentation scenarios in order to prepare a single source of truth to aid the data analysis use-cases for fintech innovation.

A common challenge faced by businesses may be aggregating a large amount of data. Moreover, real-life datasets may not provide flexibility in running specific scenarios that may require tweaking datasets to meet the requirements of a specific use case that may need to test extreme conditions such as market crashes or app failures. For instance, companies may utilize various tools such as a demand management system to aggregate a set of indicators of demand for a product or service into an aggregate indicator of demand, a transaction management system to aggregate a set of microtransactions into an aggregate transaction, and a value aggregation system to aggregate a set of assets into an aggregate asset. However, the problems in data aggregation may be daunting. In its current form, manual validation of extracted data may take a substantial number of resources including time and energy spent to format data for analysis. Moreover, the data extraction toolsets may need to be customized for each activity to ensure that the data may be accurate and consistent.

In order to meet the massive requirements of data for innovation, the financial services industry may need a new approach. That is where the technologies of Digital Twin may address these issues. Digital Twin may involve the usage of synthetic data generators which may use machine learning algorithms and statistical simulations to mimic the statistical properties of real-life datasets. The synthetic datasets of Digital Twin may also allow FinTechs to generate dynamic datasets which may create projections for multiple future scenarios incorporating alternate market, business, and lifestyle events.

In example embodiments, organizations across several verticals may deploy Robotic Process Automation (RPA) and Artificial Intelligence (AI) to increase productivity and efficiency. The growing demand for automation of business processes may be one of the significant factors influencing the increasing adoption of RPA technology. The core purpose of RPA may be to document the activities of an organization for efficient management. In a highly competitive market, it may become essential to improve work agility and deliver enhanced customer experiences. RPA robots may perform tasks across different legacy systems to get information on the digital platform. For instance, bank customers may check their account details online and process know your customer (KYC) verification and automatic bill payment along with other functions through the Internet. These services may have minimized manual involvement and may be guiding in delivering of an improved customer experience. Moreover, automated data collection may provide seamless data entry and storage and may eliminate errors and repetitions. Such practices may reduce the time and cost required to rectify the mistakes in data gathering and processing. Further, the increased demand to simplify the complex handling process may be expected to augment the industry growth.

Aggregate demand may be a measurement of the total amount of demand for all finished goods and services produced in an economy. Aggregate demand may be expressed as the total amount of money exchanged for those goods and services at a specific price level and point in time. Aggregate demand may include all consumer goods, capital goods (e.g., factories and equipment), exports, imports, and government spending. Aggregate demand may be the sum of the demand curves for different sectors of the economy. This is usually divided into four components: personal consumption such as consumer spending which may represent the demand by individuals and households within the economy, and depends on consumer incomes and the level of taxation; business investment (e.g., divided into two sub-components of fixed investment and change in private inventory) which may include purchases that organizations may create to produce consumer goods; government spending which may represent the demand produced by government programs, such as infrastructure spending and public goods (e.g., not including services such as Medicare or social security, because these programs simply transfer demand from one group to another); and net exports which may represent the demand for foreign goods, as well as foreign demand for domestic goods, and may be calculated by subtracting the total value of a country's exports from the total value of all imports.

FIG. 139 provides an exemplary block diagram illustration of a system 13900 for automated orchestration of the marketplace 12900. In particular, the system 13900 may be implemented for automated orchestration of one or more marketplaces having a robotic process automation system trained on a training set of expert interactions with a value aggregation system to aggregate a set of assets into an aggregate asset. The system 13900 may implement a processing system 13910 for this purpose. The processing system 13910 may be configured to obtain information about different items in the marketplace 12900, including information about at least one attribute associated with each of the different items. The processing system 13910 may be further configured to aggregate one or more items in the marketplace 12900 into corresponding one or more aggregate assets based, at least in part, on the respective at least one attribute associated therewith. The processing system 13910 may be further configured to generate a digital twin 13902 representing the marketplace 12900 with the one or more aggregate assets. The processing system 13910 may be further configured to facilitate one or more transactions for each one of the one or more aggregate assets independent of the other one or more aggregate assets in the marketplace 12900. Such aggregation may lead to a lot of process efficiency in the marketplace 12900.

In example embodiments, the system 13900 may be provided having a robotic process automation system trained on a training set of expert interactions with a value aggregation system to aggregate a set of assets into an aggregate asset and having an artificial intelligence system that may be configured to automatically orchestrate a transactional workflow within the marketplace 12900, as discussed in the disclosure.

In example embodiments, the system 13900 may be provided having a robotic process automation system trained on a training set of expert interactions with a demand management system to aggregate a set of indicators of demand for a product or service into an aggregate indicator of demand. The robotic process automation system may be trained on a training set of expert interactions with a transaction management system to aggregate a set of microtransactions into an aggregate transaction. The robotic process automation system may further be trained on a training set of expert interactions with a value aggregation system to aggregate a set of assets into an aggregate asset, as discussed in the disclosure.

The system 13900 may provide interesting results through use of a robotic process automation system that provides market aggregation processes that specifically provide demand aggregation, value aggregation, and/or microtransaction aggregation. In example embodiments, the system 13900 is provided having a robotic process automation system may be trained on a training set of expert interactions with a value aggregation system to aggregate a set of assets into an aggregate asset and having a set of interfaces by which a set of buyers may engage with a set of offers via a set of orchestrated workflows, where such interfaces and workflows may be embedded in a unit of a physical product; or by which a set of buyers may engage with a set of offers via a set of orchestrated workflows, where such interfaces and workflows may be embedded in a digital twin of a physical item to which the offers relate. In example embodiments, the system 13900 may be provided having a robotic process automation system trained on a training set of expert interactions with a value aggregation system to aggregate a set of assets into an aggregate asset and having a digital twin within which a set of interface elements may be presented by which a seller may orchestrate a set of offers related to the items represented in the digital twin; or presented by which a buyer may engage with a set of offers related to the items represented in the digital twin. In example embodiments, the system 13900 may be provided having a robotic process automation system trained on a training set of expert interactions with a value aggregation system to aggregate a set of assets into an aggregate asset and having a set of robotic process automation services that may be configured to automatically translate the value of an item represented in a first exchange into a value of the item for representation in a second exchange; that may be configured to generate a token that represents an item in an exchange based on characteristics of the item determined from data from a different exchange; that may be configured to generate a digital representation of a set of rights relating to an item that may be consistent with the governing rules of an exchange based on processing at least one of: a set of smart contracts and/or a set of terms and conditions relating to the item; or that may be configured to orchestrate a set of transaction workflows in each of several exchanges, such that initiation of a set of actions in one exchange may automatically result in the triggering of a set of actions in at least one other exchange.

In example embodiments, the system 13900 may be provided having a robotic process automation system trained on a training set of expert interactions with a value aggregation system to aggregate a set of assets into an aggregate asset and having: a digital twin that may represent a set of entities, workflows, and transaction parameters of exchanges, such that an interaction with the interface of the digital twin may orchestrate an interaction in each of the exchanges; a set of robotic process automation services that may be configured to inspect a set of smart contracts in each of several exchanges and to configure a smart contract that may provide terms and conditions for a transaction that may involve a transactional step in each of the several exchanges; a data and network infrastructure pipeline that may be configured to deliver data from a set of assets to an interface by which an operator may orchestrate a set of parameters for a set of transaction workflows involving the assets, where the pipeline may be automatically configured to adjust a network path based on the characteristics of the data and at least one performance parameter of the network path; a data and network path; a data and network infrastructure pipeline that may be configured to deliver data from a set of assets to an interface by which an operator may orchestrate a set of parameters for a set of transaction workflows involving the assets, where the pipeline may be automatically configured to adjust timing of data delivery based on at least one of: a transaction parameter and/or a network performance parameter; a data and network infrastructure pipeline that may be configured to deliver data from a set of assets to a set of smart contracts that may include terms, conditions, and parameters for a set of transaction workflows involving the assets, where the pipeline may be automatically configured to adjust timing of data delivery based on at least one of a transaction parameter and/or a network performance parameter; a set of application programming interfaces to a transaction environment (e.g., a marketplace or a set of marketplaces) that may be configured to be integrated into an electronic wallet system, such that interactions with a set of interfaces of the wallet system may automatically trigger a set of transaction workflows within the marketplace; a set of application programming interfaces to a marketplace that may be configured to be integrated into a digital twin platform, such that interactions with a set of interfaces of the digital twin platform may automatically trigger a set of transaction workflows within the marketplace; a set of application programming interfaces to a marketplace that may be configured to be integrated into an enterprise database platform, such that interactions with a set of interfaces of the enterprise database platform may automatically trigger a set of transaction workflows within the marketplace; a set of application programming interfaces to a marketplace that may be configured to be integrated into a platform-as-a-service platform, such that interactions with a set of interfaces of the platform-as-a-service platform may automatically trigger a set of transaction workflows within the marketplace; a set of application programming interfaces to a marketplace that may be configured to be integrated into a computer-aided design platform, such that interactions with a set of interfaces of the computer-aided design platform may automatically trigger a set of transaction workflows within the marketplace; and/or a set of application programming interfaces to a marketplace that may be configured to be integrated into a video game, such that interactions with a set of interfaces of the video game may automatically trigger a set of transaction workflows within the marketplace.

In example embodiments, the processing system 13910 may be further configured to provide a set of interface elements for a party to access at least one of the one or more aggregate assets therein independent of the other one or more aggregate assets. Such control for the parties may be able to access individual aggregate assets independently that may open up possibilities for a new type of transactions which may not have been possible otherwise.

In example embodiments, the processing system 13910 may be further configured to: record user interactions related to assigning of corresponding values, as the at least one attribute, to the different items in the marketplace 12900 and to aggregating of the different items as the one or more aggregate assets in the marketplace 12900 in relation to the assigned values thereto; configure a robotic process automation (RPA) module 13608 to mimic the user interactions related to the assigning of corresponding values to the different items and the aggregating of the different items into the one or more aggregate assets; and implement the RPA module 13608 to automatically assign value to a given item in the marketplace 12900 and to automatically aggregate one or more given items into one or more aggregate assets based on the automatically assigned values thereto in the marketplace 12900. The implementation of the RPA module 13608 may help reduce human effort which may otherwise be required in manually assigning values to individual aggregated assets, which in most cases may not even be possible for human operators to achieve with a potentially large number of aggregated assets that may be generated with the proposed example embodiment. This may ultimately help to improve operational efficiency.

In example embodiments, the processing system 13910 may be further configured to: record user interactions related to translation of values, as one of the one or more transactions, of the one or more aggregate assets from one of the exchanges in the marketplace 12900 to another one of the exchanges in the marketplace 12900; configure a robotic process automation (RPA) module to mimic the user interactions related to the translation of values of the one or more aggregate assets; and implement the RPA module 13608 to automatically translate a first value of a given aggregated asset represented in a first exchange into a second value of the given aggregated asset for representation in a second exchange. The implementation of the RPA module 13608 may help reduce human effort which may otherwise be required in manual translation of assigned values to individual aggregated assets when exchanged from one exchange to another (such as, converting currency as per prevalent exchange rates). This may ultimately help to improve operational efficiency.

In example embodiments, the processing system 13910 may be further configured to: record user interactions related to generation of a token, as one of the one or more transactions, for the one or more aggregate assets as represented in one of exchanges in the marketplace 12900 to be transferred to be representation in another one of the exchanges in the marketplace 12900; configure a robotic process automation (RPA) module to mimic the user interactions related to the generation of a token for the one or more aggregate assets; and implement the RPA module 13608 to automatically generate a token for a given aggregated asset represented in a first exchange to transfer the given aggregated asset for representation in a second exchange. This may help with providing digital ownership proofs for all of the assets in a single aggregated asset as generated herein.

In example embodiments, the processing system 13910 may be further configured to: record user interactions related to generation of digital representations of a set of rights, as one of the one or more transactions, for the one or more aggregate assets in the marketplace 12900 based on at least one of a set of smart contracts and a set of terms and conditions related to the different aggregate assets; configure a robotic process automation (RPA) module to mimic the user interactions related to the generation of digital representations of a set of rights for the one or more aggregate assets; and implement the RPA module 13608 to automatically generate a digital representation of a set of rights for a given aggregate asset in the marketplace 12900 based on at least one of a set of smart contracts and a set of terms and conditions related thereto. This may help with establishing rights in the form of smart contracts, in addition to digital ownership proofs, for all of the assets in a single aggregated asset as generated herein.

In example embodiments, the processing system 13910 may be further configured to: record user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace 12900; configure a robotic process automation (RPA) module to mimic the user interactions related to the orchestrating of a set of transaction workflows for the one or more aggregate assets; and implement the RPA module 13608 to automatically orchestrate a set of transaction workflows for a given aggregated asset by initiating a set of first actions in the at least one of the exchanges in response to triggering of a set of second actions in the at least one other exchange in the marketplace 12900. That is, based on an action in a first exchange, the RPA module 13608 may be able to automatically orchestrate a defined set of transaction workflows, complementary to the action in the first exchange, in a second exchange, or the like.

In example embodiments, the processing system 13910 may be further configured to: record user interactions related to adjusting of timing of delivery, as one of the one or more transactions, for the one or more aggregate assets based on at least one of a transaction parameter and/or a network performance parameter in the marketplace 12900; configure a robotic process automation (RPA) module to mimic the user interactions related to the adjusting of timing of delivery for the one or more aggregate assets; and implement the RPA module 13608 to automatically adjust timing of delivery for a given aggregated asset based on at least one of the transaction parameter and/or the network performance parameter in the marketplace 12900.

In example embodiments, the processing system 13910 may be further configured to: record user interactions related to determining of demand, as the at least one attribute, for the different items in the marketplace 12900 and to aggregating of the different items as the one or more aggregate assets in the marketplace 12900 in relation to the demand thereof; configure a robotic process automation (RPA) module to mimic the user interactions related to the determining of demand for the different items and the aggregating of the different items into the one or more aggregate assets; and implement the RPA module 13608 to automatically determine demand for a given item in the marketplace 12900 and to automatically aggregate one or more given items into one or more aggregate assets based on the automatically determined demands thereof in the marketplace 12900.

In example embodiments, the processing system 13910 may be further configured to: record user interactions related to curation of a set of micro-transactions for the one or more aggregate assets and processing of the curated set of micro-transactions as a single transaction for the one or more aggregate assets, as one of the one or more transactions, in the marketplace 12900; configure a robotic process automation (RPA) module to mimic the user interactions related to the curation of the set of micro-transactions for the one or more aggregate assets and processing of the curated set of micro-transactions as the single transaction for the one or more aggregate assets; and implement the RPA module 13608 to automatically curate a set of micro-transactions for a given aggregated asset and process the automatically curated set of micro-transactions as a single transaction in the marketplace 12900.

The disclosure may further provide a method for automated orchestration of the marketplace 12900. FIG. 140 provides an exemplary flowchart listing steps involved in a process or method 14000 for automated orchestration of the marketplace 12900. The various teachings of the system 13900 as described in the disclosure may apply mutatis mutandis to the process or method 14000. At step 14002, the method 14000 may include obtaining, by a processing system, information about different items in the marketplace, including information about at least one attribute associated with each of the different items. At step 14004, the method 14000 may include aggregating, by the processing system, one or more items in the marketplace into corresponding one or more aggregate assets based, at least in part, on the respective at least one attribute associated therewith. At step 14006, the method 14000 may include generating, by the processing system, a digital twin representing the marketplace with the one or more aggregate assets. In example embodiments, a digital twin(s) may allow for aggregation and disaggregation of assets and, upon user interaction, may represent metrics that may be calculated and presented in the digital twin(s) (e.g., via visual indicators) that may be based on whether the assets are aggregated or not. For example, a user may circle or click on a set of assets, which may cause them to be linked or grouped in the digital twin, and the twin may show the aggregate fair market value of those assets (e.g., such as to show that they are collectively adequate collateral for a loan or trade). At step 14002, the method 14008 may include facilitating, by the processing system, one or more transactions for each one of the one or more aggregate assets independent of the other one or more aggregate assets in the marketplace.

In example embodiments, the method 14000 may further include providing, by the processing system, a set of interface elements for a party to access at least one of the one or more aggregate assets therein independent of the other one or more aggregate assets.

In example embodiments, the method 14000 may further include: recording, by the processing system, user interactions related to assigning of corresponding values, as the at least one attribute, to the different items in the marketplace and to aggregating of the different items as the one or more aggregate assets in the marketplace in relation to the assigned values thereto; configuring, by the processing system, a robotic process automation (RPA) module to mimic the user interactions related to the assigning of corresponding values to the different items and the aggregating of the different items into the one or more aggregate assets; and implementing, by the processing system, the RPA module 13608 to automatically assign value to a given item in the marketplace and to automatically aggregate one or more given items into one or more aggregate assets based on the automatically assigned values thereto in the marketplace.

In example embodiments, the method 14000 may further include: recording, by the processing system, user interactions related to translation of values, as one of the one or more transactions, of the one or more aggregate assets from one of exchanges in the marketplace to another one of the exchanges in the marketplace; configuring, by the processing system, a robotic process automation (RPA) module to mimic the user interactions related to the translation of values of the one or more aggregate assets; and implementing, by the processing system, the RPA module 13608 to automatically translate a first value of a given aggregated asset represented in a first exchange into a second value of the given aggregated asset for representation in a second exchange.

In example embodiments, the method 14000 may further include: recording, by the processing system, user interactions related to generation of a token, as one of the one or more transactions, for the one or more aggregate assets as represented in one of the exchanges in the marketplace to be transferred to be representation in another one of the exchanges in the marketplace; configuring, by the processing system, a robotic process automation (RPA) module to mimic the user interactions related to the generation of a token for the one or more aggregate assets; and implementing, by the processing system, the RPA module 13608 to automatically generate a token for a given aggregated asset represented in a first exchange to transfer the given aggregated asset for representation in a second exchange.

In example embodiments, the method 14000 may further include: recording, by the processing system, user interactions related to generation of digital representations of a set of rights, as one of the one or more transactions, for the one or more aggregate assets in the marketplace based on at least one of a set of smart contracts and a set of terms and conditions related to the different aggregate assets; configuring, by the processing system, a robotic process automation (RPA) module to mimic the user interactions related to the generation of digital representations of a set of rights for the one or more aggregate assets; and implementing, by the processing system, the RPA module 13608 to automatically generate a digital representation of a set of rights for a given aggregate asset in the marketplace based on at least one of a set of smart contracts and a set of terms and conditions related thereto.

In example embodiments, the method 14000 may further include: recording, by the processing system, user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace; configuring, by the processing system, a robotic process automation (RPA) module to mimic the user interactions related to the orchestrating of a set of transaction workflows for the one or more aggregate assets; and implementing, by the processing system, the RPA module 13608 to automatically orchestrate a set of transaction workflows for a given aggregated asset by initiating a set of first actions in the at least one of the exchanges in response to triggering of a set of second actions in the at least one other exchange in the marketplace.

In example embodiments, the method 14000 may further include: recording, by the processing system, user interactions related to adjusting of timing of delivery, as one of the one or more transactions, for the one or more aggregate assets based on at least one of a transaction parameter and/or a network performance parameter in the marketplace; configuring, by the processing system, a robotic process automation (RPA) module to mimic the user interactions related to the adjusting of timing of delivery for the one or more aggregate assets; and implementing, by the processing system, the RPA module 13608 to automatically adjust timing of delivery for a given aggregated asset based on at least one of the transaction parameter and/or the network performance parameter in the marketplace.

In example embodiments, the method 14000 may further include: recording, by the processing system, user interactions related to determining of demand, as the at least one attribute, for the different items in the marketplace and to aggregating of the different items as the one or more aggregate assets in the marketplace in relation to the demand thereof; configuring, by the processing system, a robotic process automation (RPA) module to mimic the user interactions related to the determining of demand for the different items and the aggregating of the different items into the one or more aggregate assets; and implementing, by the processing system, the RPA module 13608 to automatically determine demand for a given item in the marketplace and to automatically aggregate one or more given items into one or more aggregate assets based on the automatically determined demands thereof in the marketplace.

In example embodiments, the method 14000 may further include: recording, by the processing system, user interactions related to curation of a set of micro-transactions for the one or more aggregate assets and processing of the curated set of micro-transactions as a single transaction for the one or more aggregate assets, as one of the one or more transactions, in the marketplace; configuring, by the processing system, a robotic process automation (RPA) module to mimic the user interactions related to the curation of the set of micro-transactions for the one or more aggregate assets and processing of the curated set of micro-transactions as the single transaction for the one or more aggregate assets; and implementing, by the processing system, the RPA module 13608 to automatically curate a set of micro-transactions for a given aggregated asset and process the automatically curated set of micro-transactions as a single transaction in the marketplace.

Value aggregation itself may present challenges, including time involved and complexity, which may be met by automating one or more aspects of the aggregation of value of microtransactions, such as by using a model that facilitates identification and curation of microtransaction aggregation opportunities, such as one that calculates and predicts the profitability of a set of microtransactions, in aggregate, based on a set of transaction parameters and based on current market conditions.

Various aspects of such a model may benefit from advanced data collection on current market conditions and transactions, as well as robotic process automation with respect to various aspects of design, operation, and iterative improvement of the model. Interactions with a value aggregation system may be automated.

In example embodiments, such a microtransaction value aggregation system may be complemented, augmented, improved, or the like, or may be replaced entirely, by a robotic process automation system, such as one that is trained on a set of training data (such as interactions of operators of the value aggregation system), to undertake automatically, without operator intervention, interactions with the value aggregation system, including parametrizing one or more models used by the system, setting weights of parameters, selecting from among recommendations, curating opportunities, selecting and/or setting up aggregation transactions, creating aggregate contract terms and conditions (including configuring, parameterizing, and/or deploying a set of smart contracts), and others. The robotic process automation system may be trained, over time, on outcomes, including in simulations and real-world deployments, to improve the value aggregation system itself and/or to improve its operation of the value aggregation system. In example embodiments, it may be trained to operate independent of the value aggregation system, such as to replace it.

In example embodiments, provided herein are computer-implemented methods and systems for automated orchestration of one or more marketplaces, such system 13900 and method 14000 having a robotic process automation system trained on a training set of expert interactions with a value aggregation system to aggregate a set of assets into an aggregate asset. As described herein, value aggregation itself may present challenges, including time involved and complexity, which may be met by automating one or more aspects of the aggregation of value of microtransactions, such as by using a model that may facilitate identification and curation of microtransaction aggregation opportunities, such as one that may calculate and predict the profitability of a set of microtransactions, in aggregate, based on a set of transaction parameters and based on current market conditions. As noted in the disclosure, various aspects of such a model may benefit from advanced data collection on current market conditions and transactions, as well as robotic process automation with respect to various aspects of design, operation, and iterative improvement of the model. In example embodiments, interactions with the value aggregation system may be automated. For example, a human operator may aggregate sets of transactions by discovering a set of similar transactions in the value aggregation system (such as ones involving similar attributes of timing, goods, consideration, geography, or the like), grouping the similar transactions, and generating a set of terms and conditions for an aggregated transaction that encompasses the microtransactions (including one that proposes changes to harmonize or normalize the transactions for aggregation, such as by proposing an amendment of terms and conditions to render the microtransactions suitable for aggregation). In example embodiments, such a microtransaction value aggregation system may be complemented, augmented, improved, or the like, or may be replaced entirely, by a robotic process automation system, such as one that may be trained on a set of training data (such as interactions of operators of the value aggregation system), to undertake automatically, without operator intervention, interactions with the value aggregation system, including parametrizing one or more models used by the system, setting weights of parameters, selecting from among recommendations, curating opportunities, selecting and/or setting up aggregation transactions, creating aggregate contract terms and conditions (including configuring, parameterizing and/or deploying a set of smart contracts), and others. The robotic process automation system may be trained, over time, on outcomes, including in simulations and real-world deployments, to improve the value aggregation system itself and/or to improve its operation of the value aggregation system. In example embodiments, it may be trained to operate independent of the value aggregation system, such as to replace it. Outcomes may include various measures of transaction success mentioned throughout this disclosure, including per-transaction profit, aggregate profit, and others. The model and/or robotic process automation system may use artificial intelligence systems as described throughout this disclosure and the documents incorporated herein by reference.

In example embodiments, such system 13900 and method 14000 are provided having a robotic process automation system trained on a training set of expert interactions with a value aggregation system to aggregate a set of assets into an aggregate asset and having an artificial intelligence system that may be configured to automatically orchestrate a transactional workflow within a transaction environment (e.g., a marketplace or a set of marketplaces). In example embodiments, such system 13900 and method 14000 are provided having a robotic process automation system that may be trained on a training set of expert interactions with a value aggregation system to aggregate a set of assets into an aggregate asset and having a set of interfaces by which a set of buyers may engage with a set of offers via a set of orchestrated workflows, where such interfaces and workflows may be embedded in a unit of a physical product. In example embodiments, such system 13900 and method 14000 are provided having a robotic process automation system trained on a training set of expert interactions with a value aggregation system to aggregate a set of assets into an aggregate asset and having a set of interfaces by which a set of buyers may engage with a set of offers via a set of orchestrated workflows, where such interfaces and workflows may be embedded in a digital twin of a physical item to which the offers relate. In example embodiments, such system 13900 and method 14000 are provided having a robotic process automation system trained on a training set of expert interactions with a value aggregation system to aggregate a set of assets into an aggregate asset and having a digital twin within which a set of interface elements may be presented by which a seller may orchestrate a set of offers related to the items represented in the digital twin. In example embodiments, such system 13900 and method 14000 are provided having a robotic process automation system trained on a training set of expert interactions with a value aggregation system to aggregate a set of assets into an aggregate asset and having a digital twin within which a set of interface elements may be presented by which a buyer may engage with a set of offers related to the items represented in the digital twin. In example embodiments, such system 13900 and method 14000 are provided having a robotic process automation system trained on a training set of expert interactions with a value aggregation system to aggregate a set of assets into an aggregate asset and having a set of robotic process automation services that may be configured to state the value of a set of items that may be represented in exchanges, such that representation of the value of each member of the set of items in the exchanges may be normalized based on the native currencies of the respective exchanges. In example embodiments, such system 13900 and method 14000 are provided having a robotic process automation system trained on a training set of expert interactions with a value aggregation system to aggregate a set of assets into an aggregate asset and having a set of robotic process automation services that may be configured to automatically translate the value of an item represented in a first exchange into a value of the item for representation in a second exchange. In example embodiments, such system 13900 and method 14000 may be provided having a robotic process automation system trained on a training set of expert interactions with a value aggregation system to aggregate a set of assets into an aggregate asset and having a set of robotic process automation services that may be configured to generate a token that represents an item in an exchange based on characteristics of the item determined from data from a different exchange. In example embodiments, such system 13900 and method 14000 may be provided having a robotic process automation system trained on a training set of expert interactions with a value aggregation system to aggregate a set of assets into an aggregate asset and having a set of robotic process automation services that may be configured to generate a digital representation of a set of rights relating to an item that may be consistent with the governing rules of an exchange based on processing at least one of a set of smart contracts and a set of terms and conditions relating to the item. In example embodiments, such system 13900 and method 14000 are provided having a robotic process automation system that may be trained on a training set of expert interactions with a value aggregation system to aggregate a set of assets into an aggregate asset and having a set of robotic process automation services that may be configured to orchestrate a set of transaction workflows in each of several exchanges, such that initiation of a set of actions in one exchange automatically results in the triggering of a set of actions in at least one other exchange. In example embodiments, such system 13900 and method 14000 are provided having a robotic process automation system trained on a training set of expert interactions with a value aggregation system to aggregate a set of assets into an aggregate asset and having a digital twin that represents a set of entities, workflows, and transaction parameters of exchanges, such that interaction with the interface of the digital twin may orchestrate an interaction in each of the exchanges. In example embodiments, such system 13900 and method 14000 are provided having a robotic process automation system trained on a training set of expert interactions with a value aggregation system to aggregate a set of assets into an aggregate asset and having a set of robotic process automation services that may be configured to inspect a set of smart contracts in each of the exchanges and to configure a smart contract that provides terms and conditions for a transaction that involves a transactional step in each of the exchanges. In example embodiments, such system 13900 and method 14000 are provided having a robotic process automation system trained on a training set of expert interactions with a value aggregation system to aggregate a set of assets into an aggregate asset and having a data and network infrastructure pipeline that may be configured to deliver data from a set of assets to an interface by which an operator orchestrates a set of parameters for a set of transaction workflows involving the assets, where the pipeline may be automatically configured to adjust a network path based on the characteristics of the data and at least one performance parameter of the network path. In example embodiments, such system 13900 and method 14000 are provided having a robotic process automation system trained on a training set of expert interactions with a value aggregation system to aggregate a set of assets into an aggregate asset and having a data and network infrastructure pipeline that may be configured to deliver data from a set of assets to a set of smart contracts that include terms, conditions, and parameters for a set of transaction workflows involving the assets, where the pipeline may be automatically configured to adjust a network path based on the characteristics of the data and at least one performance parameter of the network path. In example embodiments, such system 13900 and method 14000 are provided having a robotic process automation system trained on a training set of expert interactions with a value aggregation system to aggregate a set of assets into an aggregate asset and having a data and network infrastructure pipeline that may be configured to deliver data from a set of assets to an interface by which an operator orchestrates a set of parameters for a set of transaction workflows involving the assets, where the pipeline may be automatically configured to adjust timing of data delivery based on at least one of a transaction parameter and a network performance parameter. In example embodiments, such system 13900 and method 14000 are provided having a robotic process automation system trained on a training set of expert interactions with a value aggregation system to aggregate a set of assets into an aggregate asset and having a data and network infrastructure pipeline that may be configured to deliver data from a set of assets to a set of smart contracts that include terms, conditions, and parameters for a set of transaction workflows involving the assets, where the pipeline may be automatically configured to adjust timing of data delivery based on at least one of a transaction parameter and/or a network performance parameter. In example embodiments, such system 13900 and method 14000 are provided having a robotic process automation system trained on a training set of expert interactions with a value aggregation system to aggregate a set of assets into an aggregate asset and having a set of application programming interfaces to a transaction environment (e.g., a marketplace or a set of marketplaces) that may be configured to be integrated into an electronic wallet system, such that interactions with a set of interfaces of the wallet system may automatically trigger a set of transaction workflows within the marketplace. In example embodiments, such system 13900 and method 14000 are provided having a robotic process automation system trained on a training set of expert interactions with a value aggregation system to aggregate a set of assets into an aggregate asset and having a set of application programming interfaces to a marketplace that may be configured to be integrated into a digital twin platform, such that interactions with a set of interfaces of the digital twin platform may automatically trigger a set of transaction workflows within the marketplace. In example embodiments, such system 13900 and method 14000 are provided having a robotic process automation system trained on a training set of expert interactions with a value aggregation system to aggregate a set of assets into an aggregate asset and having a set of application programming interfaces to a marketplace that may be configured to be integrated into an enterprise database platform, such that interactions with a set of interfaces of the enterprise database platform may automatically trigger a set of transaction workflows within the marketplace. In example embodiments, such system 13900 and method 14000 are provided having a robotic process automation system trained on a training set of expert interactions with a value aggregation system to aggregate a set of assets into an aggregate asset and having a set of application programming interfaces to a marketplace that may be configured to be integrated into a platform-as-a-service platform, such that interactions with a set of interfaces of the platform-as-a-service platform may automatically trigger a set of transaction workflows within the marketplace. In example embodiments, such system 13900 and method 14000 are provided having a robotic process automation system trained on a training set of expert interactions with a value aggregation system to aggregate a set of assets into an aggregate asset and having a set of application programming interfaces to a marketplace that are configured to be integrated into a computer-aided design platform, such that interactions with a set of interfaces of the computer-aided design platform may automatically trigger a set of transaction workflows within the marketplace. In example embodiments, such system 13900 and method 14000 are provided having a robotic process automation system trained on a training set of expert interactions with a value aggregation system to aggregate a set of assets into an aggregate asset and having a set of application programming interfaces to a marketplace that may be configured to be integrated into a video game, such that interactions with a set of interfaces of the video game may automatically trigger a set of transaction workflows within the marketplace.

The market aggregation may find many real-world applications. For instance, one example may involve a renewable-powered electricity grid “volatility of energy supply” as a key issue. The grid control system may need to match a feed-in and consumption of electric power in real-time. The grid control system may have an urgent “physiological machine need” to access flexibilities such as batteries to store excess energy or request delivery of energy. In an example embodiment, algorithms aggregating flexibilities may sell their customer the grid control system, including access to and control an aggregated and validated portfolio of flexibilities. This service may optimize a reliable use of flexibilities via algorithms that may be charged and create revenue streams for the algorithms (e.g., self-owned algorithms that may include or utilize aggregation bots) including a small algorithmic profit.

In example embodiments, there may be a variety of market aggregation systems that utilize and/or include the following as described in the disclosure: Natural language-based intelligent agents (e.g., natural language processing (NLP), text-to-speech (TTS), speech-to-text (STT), etc.); Search engines (e.g., general search engines, crawlers, spiders, clustering engines, federated search engines, and the like); Crowdsourcing orchestration systems; Identity authentication engines (e.g., cryptographic, biometric, and the like); Smart contract orchestration engines; Recommendation engines (e.g., similarity/clustering, collaborative filtering, rule-based, hybrids, and the like); Robotic process automation systems; Digital twin systems (e.g., adaptive/dynamic); Data routing engines (e.g., context-based); Data processing engines (e.g., extract, transform, load (ETL), normalization, compression, and the like); Generative machine learning systems; AI systems (e.g., classification/tagging, prediction, optimization, control, deep learning, supervised/semi-supervised learning systems, machine learning (ML, and the like), robotic process automation (RPA)); Control systems (SCADA, remote control, autonomous, semi-autonomous, and the like); and/or decentralized autonomous organization (DAOs). These systems may be utilized for various examples as described in the disclosure when relevant functionality may be needed.

### Embedded Marketplaces

One path to retain vendors and customers in the long term for marketplaces includes adding new services. For example, such new services may be ancillary/supplementary value-added services. These value-added services have the potential to create “stickiness” with retention of both vendors and customers. Potential benefits include disincentivizing switching to a competitor, helping vendors with their operations, and creating new revenue streams for marketplace platforms.

For instance, embedding finance into a marketplace may be a great retention strategy for marketplaces. By integrating financial services into a vendor account or digital journey, the platform creates stickiness and attracts and retains the best suppliers by providing a superior experience. Therefore, the marketplace may gain a competitive advantage for hosting the best products and services, and may attract more customers.

Developing a successful embedded business solution, however, is full of challenges. These challenges go beyond the complex technology itself, and include the rigorous work of designing to specific functional and environmental requirements of a target application. This is especially true as a business may scale quickly and take on accepted industry practices with, for example, payment and credit terms. Highly regulated industries like healthcare, industrial automation, financial markets, and others require that the businesses conform to a wide variety of standards. For example, conforming to a wide variety of standards is not simple with respect to the safety standards of the medical industry, the regulatory requirements of the automation industry, or the risk-prone environments of the finance industry.

Business-to-Business (B2B) marketplaces are digital platforms where businesses offer their products or services to other businesses. They create “self-serve” and curated environments that allow companies to trade with other businesses they might not otherwise have connected with directly. Buyers get choice, value and greater efficiencies, while sellers ease the burden of marketing or logistics. They create a digital safe space for business e-commerce by making transactions simpler and more transparent.

Embedding financial services on the customer-side of a marketplace promotes increased demand and return customers which will attract even more suppliers and vendors to the platform. Embedding financial services on a vendor side of a marketplace may permit enhanced management of some of the most important aspects of a business consolidated into one place. This will also give marketplaces the opportunity to help vendors improve the financial well-being of their business, which will ultimately lead to happier end-customers, with pricing consistency, inventory management, budgeting and cashflow management, etc. Accordingly, the embedded platforms may benefit each of the platform, the vendor, and the customer.

Embedded procurement is an evolution of embedded finance. There are several reasons why it makes sense for businesses to procure their supplies through software: centralization and efficiency of using a single platform, price transparency, customization predicated on past order history, and access to negotiated price discounts. Beyond those advantages, a more subtle yet powerful benefit is in the synergy between embedded fintech and procurement. More broadly, if a software company knows the purchasing behavior of its customer, such as what, when, and how they buy, that information can and should inform its financial services offerings.

Financing decisions may be enhanced by analyzing a company's granular cash flows. Embedded procurement completes the circle: software platforms with embedded procurement may see not only incoming payments from customers, but also detailed outgoing payments to suppliers (who, for what, and when).

Marketplaces may match industry standard terms, such as 30 or even 90 day terms, to attract buyers in the first place. This results in complex management of buyer credit terms and payment collections, and requires taking on credit risk with large orders. Marketplaces get into danger if they try to make themselves more attractive to and retain the best businesses in the industry by paying earlier. This may leave them struggling to finely balance management of cash flow, liquidity and credit risk that can strangle growth.

Embodiments of the embedded marketplaces described herein embrace innovative payments solutions that provide a secure and intuitive way to checkout. Providing secure transactions for the seller and offering favorable payment terms to the buyer builds online trust for the embedded marketplaces. By embedding finance options such as paying later or with better credit terms within the checkout journey, marketplaces can match and beat other purchasing options offline. Embedded finance also permits buyers to avoid the hassle of managing credit or impacting their balance sheet themselves.

FIG. 141 provides an exemplary block diagram illustration of a system 14100 for augmenting of services in the marketplace 12900. The system 14100 comprises a processing system 14110. In embodiments, the processing system 14110 may be configured to generate a digital twin of the marketplace 12900, where the digital twin is a digital representation of a set of parties in the marketplace 12900 and a set of services available in the marketplace 12900. The processing system 14110 is further configured to monitor service transactions between the set of parties in the marketplace 12900. The processing system 14110 is further configured to analyze a nature of a current service transaction by a given party of the set of parties in the marketplace 12900 based on the monitoring. The processing system 14110 is further configured to determine, by implementing the digital twin, a supplementary service from the set of services related to the current service transaction suitable for the given party based on the nature of the current service transaction. The processing system 14110 is further configured to provide a recommendation for the supplementary service to the given party.

Embedded marketplaces and systems for embedded marketplaces provide more flexible and effective exchanges of value of assets across a wide range of environments and systems encountered by customers. Layers and suites of technologies enable services that serve as fully functional marketplaces, embedded and automatically orchestrated. Marketplaces exist everywhere in the world, both physically and digitally, yet embedded marketplaces may change the way those marketplaces operate, opening up new avenues of transaction within them and numerous more opportunities for exchanges where currently there are none. An embedded marketplace system allows for more automation and personalization within marketplaces, improving transaction experiences and market efficiency.

As a combination of technologies converge rapidly to automate the orchestration of marketplaces, they are becoming increasingly embedded within a wide range of environments and systems encountered by customers. Using layers of technologies and suites of enabling services, embedded marketplaces can serve both a wide range of stakeholders seeking to more effectively monetize assets and consumers looking for a more personalized, user-friendly shopping experience. In today's society, exchanging value, through sales or services, is pervasive. However, for most transactions to occur, a consumer needs to visit a transaction environment (e.g., a marketplace or a set of marketplaces), either in the real world or online, where a host relies on a wide range of technologies, human inputs, and third parties to orchestrate and enable the transaction. The embedded marketplaces described herein remove that necessity, opening up the possibility for new types of transactions and interactions between vendor and consumer.

One space that both benefits from and may contribute to the success for embedded marketplaces is virtual reality (VR). A virtual environment using a digital twin of a transaction environment (e.g., digital twin(s) of a marketplace or a set of marketplaces) may allow a user to walk around a store and select items without needing to go to a brick & mortar store. As online shopping increasingly displaces in-person shopping, many customers find themselves dealing with the drawbacks of digital transactions. For example, it may be almost impossible for consumers to know with complete confidence that a specific and singular article of clothing will fit them unless they try it on their own body directly. VR may change that by displaying rendered or precision representations of online shoppers trying on a digital version of the item they are purchasing. As VR and other nascent technologies become more sophisticated, this process may allow users to shop online with greater confidence than they ever could in person, where stores often do not carry all sizes or where there may be variation within a batch of supposedly same-sized articles of clothing. As artificial intelligence (AI) and data processing develops further, it is possible that a virtual marketplace may make suggestions for clothing based on the shopper's personal style, measurements, and perceived confidence level. For example, a virtual shopper, processing a single shopper's wardrobe and past fashion choices, may pick up on quirks in their styling preferences, such as a preference to cover knees and shoulders, or a tendency to purchase clothes that accentuate a certain feature or prioritize specific colors or color combinations. The virtual shopper can recommend items with these traits in mind, guided by AI. Additionally, the consumer may be able to log their outfits and note specific feedback or features for an individual item to inform future guidance. The virtual shopper can then determine how often the individual wears certain items, as compared to how often they purchase items like them. This addresses the most annoying aspect of the online shopping algorithm as it currently operates—it shows you more of what you already have, rather than what you might need or want. A virtual shopper may operate more intelligently than the algorithm in its current form, suggesting items that fit the consumer's taste rather than their shopping history. Thus, if a consumer already has three navy blue blazers that they never wear, the virtual shopper will stop recommending navy blue blazers.

In example embodiments, the processing system 14110 is further configured to: generate an artificial intelligence (AI) model (such as, the AI model 13606) trained on information about relationship between different services of the set of services available in the marketplace 12900; and implement the AI model 13606 to determine the supplementary service from the set of services related to the current service transaction suitable for the given party. In example embodiments, the supplementary service comprises at least one of: a guarantee service, an insurance service, a loan service, a discount service, a promotion service, a verification service, a validation service, a sponsorship service, a rewards service, a tax service, a fraud alert service, or a compliance service. In example embodiments, the supplementary service is a value-added service. In embodiments, the embedded marketplace populates sale data from known parameter or characteristics of items/data. In embodiments, the embedded marketplace posts offers. In embodiments, items including the embedded marketplace are geotagged. For example, during a drive through upstate New York, a digital wallet may include an embedded marketplace that looks for nearby antique stores or items in the antique stores that may be identified by another embedded marketplace.

In example embodiments, the one of the parties in the set of parties in the marketplace 12900 is a consumer comprising at least one of: a person, an enterprise, a machine, a real estate, a manufacturer, or an asset owner. In example embodiments, the one of the parties in the set of parties in the marketplace 12900 is a service provider comprising at least one of: a merchant, a payments provider, a guarantor, an identity manager (e.g., identity authentication engines), an insurer, a banker, a lender, a host, or a presenter. In example embodiments, the stakeholder interfaces to embedded marketplaces include Manufacturer API, Merchant API, Payments provider API, Insurer API, Guarantor API, Identity Manager API, Banker/Lender API, Service Provider API, Host API, Consumer API, Asset owner/operator API, and Presenter API for search, mobile app, ecommerce, mobile device, smart TV, manufacturer, and the like.

In example embodiments, the provided set of services in the marketplace 12900 is configurable by the service provider. Such cloud-deployed service sets/suites for embedded markets may enable the service provider to provide services including guarantee, insure, float/fund/lend, find party, find goods, find services, match needs, recommend, rate, verify/validate, price, promote/advertise, sponsor, reconcile, prevent fraud, identify, comply, pay taxes, rewind/unwind transaction (innovation category), aggregate, reward, validate, guide/inform, and the like.

In example embodiments, analyzing the nature of the current service transaction comprises estimating interconnectedness of other transaction services related to the current service transaction, and wherein the supplementary service is determined based on the estimated interconnectedness of other transaction services. In example embodiments, analyzing the nature of the current service transaction comprises estimating likeness of other transaction services, related to the current service transaction, by other parties of the set of parties in the marketplace 12900, and wherein the supplementary service is determined based on the estimated likeness of other transaction services.

In example embodiments, the marketplace 12900 is a virtual environment. In example embodiments, the embedded marketplace is decentralized/peer-to-peer. In example embodiments, the embedded marketplace relates to embedding a functioning marketplace in at least one of: a digital twin (in-twin marketplace), such as digital twin of a person, digital twin of a product, digital twin of an enterprise, digital twin of a machine, digital twin of real estate, digital twin of personal property; a virtual environment; a digital wallet; a product; a wearable product; infrastructure (IoT/edge/network); a database; and the like.

The present disclosure further provides a method for augmenting of services in the marketplace 12900. FIG. 142 provides an exemplary flowchart listing steps involved in a method 14200 for augmenting of services in the marketplace 12900. The various teachings of the system 14100 as described in the disclosure may apply mutatis mutandis to the present method 14200. At step 14202, the method 14200 includes generating, by a processing system, a digital twin of the marketplace 12900, wherein the digital twin is a digital representation of a set of parties in the marketplace 12900 and a set of services available in the marketplace 12900. At step 14204, the method 14200 includes monitoring, by the processing system, service transactions between the set of parties in the marketplace 12900. At step 14206, the method 14200 includes analyzing, by the processing system, a nature of a current service transaction by a given party of the set of parties in the marketplace 12900 based on the monitoring. At step 14208, the method 14200 includes determining, by the processing system, by implementing the digital twin, a supplementary service from the set of services related to the current service transaction suitable for the given party based on the nature of the current service transaction. At step 14210, the method 14200 includes providing, by the processing system, a recommendation for the supplementary service to the given party.

In example embodiments, the method 14200 further comprises: generating, by the processing system, an artificial intelligence (AI) model trained on information about relationship between different services of the set of services available in the marketplace 12900; and implementing, by the processing system, the AI model 13606 to determine the supplementary service from the set of services related to the current service transaction suitable for the given party.

In example embodiments, the method 14200 further comprises the supplementary service comprises at least one of: a guarantee service, an insurance service, a loan service, a discount service, a promotion service, a verification service, a validation service, a sponsorship service, a rewards service, a tax service, a fraud alert service, or a compliance service.

In example embodiments, the method 14200 further comprises the supplementary service is a value-added service.

In example embodiments, the method 14200 further comprises the one of the parties in the set of parties in the marketplace 12900 is a consumer comprising at least one of: a person, an enterprise, a machine, a real estate, a manufacturer, or an asset owner.

In example embodiments, the method 14200 further comprises the one of the parties in the set of parties in the marketplace 12900 is a service provider comprising at least one of: a merchant, a payments provider, a guarantor, an identity manager, an insurer, a banker, a lender, a host, or a presenter.

In example embodiments, the method 14200 further comprises the provided set of services in the marketplace 12900 is configurable by the service provider.

In example embodiments, the method 14200 further comprises analyzing the nature of the current service transaction comprises estimating interconnectedness of other transaction services related to the current service transaction, and wherein the supplementary service is determined based on the estimated interconnectedness of other transaction services.

In example embodiments, the method 14200 further comprises analyzing the nature of the current service transaction comprises estimating likeness of other transaction services, related to the current service transaction, by other parties of the set of parties in the marketplace 12900, and wherein the supplementary service is determined based on the estimated likeness of other transaction services.

In example embodiments, the marketplace 12900 is a virtual environment. In embodiments, the embedded marketplace is decentralized/peer-to-peer.

Embedded marketplaces can likely be applied in many places where information is gathered about specific items or services. The information about the product/service is likely already gathered and may be entered automatically in the marketplace without user memory or entry errors. The extra steps of visiting a non-embedded marketplace are omitted. Thus, on an individualized level, embedded marketplaces may change the way online shopping operates. For example, if a social media user likes a sponsored post of a meal prepared by one of their favorite influencers, they may be able to purchase individual ingredients without having to click through the seller's online marketplace or track down a link to the item. If the influencer used a meal kit, the influencer would not have to tag the vendor for their followers to find where they purchased the item. Additionally, if the influencer used a specific recipe, an embedded marketplace system may be able to display or direct the user to the recipe, including a one-click purchase bundle of all the ingredients required for it. While this may seem small, the concept can be extended further to encapsulate increasingly complex algorithms of personalization. For instance, the influencer might only eat local to their area or use organic products out of the price range of most of their followers. Embedded marketplaces may provide options to purchase similar ingredients that effectively replace the ones used by the influencer. This would be beneficial in situations where the ingredients are out of season or stock—the embedded marketplace system may provide similar substitutes that would still capture the same flavor profiles. On an even more granular level, it is possible that the user could toggle their preferences if they have food restrictions. For example, if a user is gluten free, the embedded marketplace may supply a bundle of ingredients that includes gluten free substitutes for the recipe. The embedded marketplace system can use internal search engine optimization to find and show the customer a variety of items that fit the general essence they are trying to emulate at a range of price points.

A unique application for embedded marketplaces may be used in transactions that do not necessarily have concrete deliverables. Currently, many news outlets are struggling financially, in part due to the shift from physical to digital media. News outlets must make the difficult choice between raising subscription pricing or selling ad space, either of which can be easily disbalanced to drive away customers and decrease revenue just as much as they were trying to grow. A readership embedded marketplace may open up possibilities within the subscription model, allowing customers to purchase access to individual articles or even sections of articles that are relevant to their interests. An embedded marketplace may incorporate AI to see what topics are most relevant to a reader's interests, suggesting other articles that touch on those interests. This could help longer, and more niche articles get more attention-if a reader who frequently reads about specific topics in their local paper but not nationally, e.g., wildlife trends that would not impact them except locally, the reader would be pushed the information and would know that something that matters to them is coming towards the end of the article. This could cause the reader to be more likely to pay for that article and read the entire thing. This would also track the number of articles read in a single new site, allowing the AI to recommend a full subscription if it fits the user's reading habits. Potentially, the AI may then toggle the subscription on and off depending on whether the user continues to read articles from that new site. Thus, embedded marketplaces can be used in flexible ways, tailoring its design to the marketplace in which it is being embedded.

In embodiments, the readership embedded marketplace may apply to scholarly articles, such as thesis papers and journal articles. The offered articles may be further based on the characterization of the consumer, such as whether they are deeply interested in politics, religion, physics, botany, or other fields. For example, the readership embedded marketplace may offer access to journal articles about hydrodynamic scour during news segments in a media program discussing bridge collapses or levee breaches where the consumer is interested in physics. In some embodiments, the readership embedded marketplace may collect various free-to-read pieces of writing as a value-added service or for a fee. For example, a consumer may be presented with previous publicly available court decisions written by a specific judge where that consumer has shown an interest in politics/law and is using a platform that discusses that specific judge as a nominee for the Supreme Court of the United States.

The embedded marketplace may ultimately aggregate all information about a particular party to provide a “personal wallet” which is a wallet for everything of value, such as currencies including money, cryptocurrencies, points, tokens; property including personal property, real estate, digital goods and content, shareable property; influence including likeness, social network connections, followers; future value streams; capacities of “commodities” including compute, energy; time including attention, task completion like surveys/focus groups; expertise/insight including to train AI, to train others, to complete tasks; affinity/loyalty, personal data, and the like. The embedded marketplace may further provide an ultimate monetization platform and an ultimate sharing for the said elements in such personal wallet.

The embedded marketplace may be used for Market-to-Market integration for providing intelligent data collection from other markets, asset markets and exchanges, currency markets, fiat, crypto, other embedded markets, APIs to other markets, value conversion between markets, automated transaction configuration, execution and reconciliation in other markets, etc. The present disclosure further provide for orchestration of embedded marketplaces by providing APIs for all stakeholders, APIs for all services, context-based orchestration and configuration of service sets, counterparty matching and search by finding areas of mutual exchange, presentation layer, search and prioritization of available services, search and prioritization of available sources of value, configuration of transaction models including auctions, reverse auctions, selectable consideration including flexibly configured combinations of value as consideration (e.g., combination of time, influence, money and energy capacity), bid/auction for participation/presentation in which service providers bid to present services in wallet for transaction-specific/micro-services, and the like.

### Legal

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements.

Example relationship terms include “adjoining,” “transmitting,” “receiving,” “connected,” “engaged,” “coupled,” “adjacent,” “next to,” “on top of,” “above,” “below,” “abutting,” and “disposed.”

The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure.

No language in the specification should be construed as indicating that any non-claimed element is essential or critical to the practice of the disclosure.

The term “exemplary” simply means “example” and does not indicate a best or preferred example.

The term “set” does not necessarily exclude the empty set—in other words, in some circumstances a “set” may have zero elements. The term “non-empty set” may be used to indicate exclusion of the empty set—that is, a non-empty set must have one or more elements.

The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The phrase “at least one of A, B, and C” should be construed to mean a logical (A OR B OR C), using a non-exclusive logical OR, and should not be construed to mean “at least one of A, at least one of B, and at least one of C.”

The use of the terms “a,” “an,” “the,” and similar referents in the context of describing the disclosure and claims encompasses both the singular and the plural, unless contradicted explicitly or by context.

Unless otherwise specified, the terms “comprising,” “having,” “with,” “including,” and “containing,” and their variants, are open-ended terms, meaning “including, but not limited to.”

Each publication referenced in this disclosure, including foreign and domestic patent applications and patents, is hereby incorporated by reference in its entirety.

Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure.

One or more elements (for example, steps within a method, instructions, actions, or operations) may be executed in a different order (and/or concurrently) without altering the principles of the present disclosure.

Unless technically infeasible, elements described as being in series may be implemented partially or fully in parallel. Similarly, unless technically infeasible, elements described as being in parallel may be implemented partially or fully in series.

While the disclosure describes structures corresponding to claimed elements, those elements do not necessarily invoke a means plus function interpretation unless they explicitly use the signifier “means for.”

While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks.

Unless explicitly stated as mutually exclusive, features depicted in different drawings can be combined consistent with the principles of the present disclosure.

In the drawings, reference numbers may be reused to identify identical elements or may simply identify elements that implement similar functionality.

Numbering or other labeling of instructions or method steps is done for convenient reference, not to indicate a fixed order.

In the drawings, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. As just one example, for information sent from element A to element B, element B may send requests and/or acknowledgements to element A.

Unless otherwise indicated, recitations of ranges of values are merely intended to serve as a shorthand way of referring individually to each separate value falling within the range, and each separate value is hereby incorporated into the specification as if it were individually recited.

### Special-Purpose System

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

In this application, including the claims, the term module refers to a special-purpose system. The module may be implemented by one or more special-purpose systems. The one or more special-purpose systems may also implement some or all of the other modules.

In this application, including the claims, the term module may be replaced with the terms controller or circuit.

In this application, including the claims, the term platform refers to one or more modules that offer a set of functions.

In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment.

For example, the special-purpose system may be partially or fully hosted by a third party offering software as a service (SaaS), platform as a service (PaaS), and/or infrastructure as a service (IaaS).

The special-purpose system may be implemented using agile development and operations (DevOps) principles. In embodiments, some or all of the special-purpose system may be implemented in a multiple-environment architecture. For example, the multiple environments may include one or more production environments, one or more integration environments, one or more development environments, etc.

### Device Examples

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc.

A special-purpose system may be partially or fully implemented using or by a network device. Examples of network devices include switches, routers, firewalls, gateways, hubs, base stations, access points, repeaters, head-ends, user equipment, cell sites, antennas, towers, etc.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system.

Examples of servers include a file server, print server, domain server, internet server, intranet server, cloud server, infrastructure-as-a-service server, platform-as-a-service server, web server, secondary server, host server, distributed server, failover server, and backup server.

### Hardware

The term hardware encompasses components such as processing hardware, storage hardware, networking hardware, and other general-purpose and special-purpose components. Note that these are not mutually-exclusive categories. For example, processing hardware may integrate storage hardware and vice versa.

Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack.

Examples of a system-on-chip include a radio frequency (RF) system-on-chip, an artificial intelligence (AI) system-on-chip, a video processing system-on-chip, an organ-on-chip, a quantum algorithm system-on-chip, etc.

The hardware may integrate and/or receive signals from sensors. The sensors may allow observation and measurement of conditions including temperature, pressure, wear, light, humidity, deformation, expansion, contraction, deflection, bending, stress, strain, load-bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

### Processing Hardware

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

### Processor Architecture

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application.

A processor may be implemented as a packaged semiconductor die. The die includes one or more processing cores and may include additional functional blocks, such as cache. In various embodiments, the processor may be implemented by multiple dies, which may be combined in a single package or packaged separately.

### Networking Hardware

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

Examples of cellular networks include GSM, GPRS, 3G, 4G, 5G, LTE, and EVDO. The cellular network may be implemented using frequency division multiple access (FDMA) network or code division multiple access (CDMA) network.

Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard).

Examples of a WPAN include IEEE Standard 802.15.4, including the ZIGBEE standard from the ZigBee Alliance. Further examples of a WPAN include the BLUETOOTH wireless networking standard, including Core Specification versions 3.0, 4.0, 4.1, 4.2, 5.0, and 5.1 from the Bluetooth Special Interest Group (SIG).

A WAN may also be referred to as a distributed communications system (DCS). One example of a WAN is the internet.

### Storage Hardware

Storage hardware is or includes a computer-readable medium. The term computer-readable medium, as used in this disclosure, encompasses both nonvolatile storage and volatile storage, such as dynamic random access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

### Examples

Examples of storage implemented by the storage hardware include a database (such as a relational database or a NoSQL database), a data store, a data lake, a column store, a data warehouse.

Example of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware.

Storage hardware may have read-only, write-once, or read/write properties. Storage hardware may be random access or sequential access. Storage hardware may be location-addressable, file-addressable, and/or content-addressable.

Example of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM).

Example of volatile memory devices include processor registers and random access memory (RAM), such as static RAM (SRAM), dynamic RAM (DRAM), synchronous DRAM (SDRAM), synchronous graphics RAM (SGRAM), and video RAM (VRAM).

Example of magnetic storage media include analog magnetic tape, digital magnetic tape, and rotating hard disk drive (HDDs).

Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain.

Entities recording transactions, such as in a blockchain, may reach consensus using an algorithm such as proof-of-stake, proof-of-work, and proof-of-storage.

Elements of the present disclosure may be represented by or encoded as non-fungible tokens (NFTs). Ownership rights related to the non-fungible tokens may be recorded in or referenced by a distributed ledger.

Transactions initiated by or relevant to the present disclosure may use one or both of fiat currency and cryptocurrencies, examples of which include bitcoin and ether.

Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

### Software

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc.

Software also includes data. However, data and instructions are not mutually-exclusive categories. In various embodiments, the instructions may be used as data in one or more operations. As another example, instructions may be derived from data.

The functional blocks and flowchart elements in this disclosure serve as software specifications, which can be translated into software by the routine work of a skilled technician or programmer.

Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains.

When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT).

Training a machine-learning model may include supervised learning (for example, based on labelled input data), unsupervised learning, and reinforcement learning. In various embodiments, a machine-learning model may be pre-trained by their operator or by a third party.

Problem domains include nearly any situation where structured data can be collected, and includes natural language processing (NLP), computer vision (CV), classification, image recognition, etc.

### Architectures

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc.

In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

What is claimed is:

1. A computer-implemented method for automation of transactions in a transaction environment, the method comprising:
generating, by a processing system, a digital twin of a marketplace, wherein the digital twin is a digital representation of a structure of the marketplace, the structure being representative of a set of entities of the marketplace including items in the marketplace, parties in the marketplace, and one or more Internet of Things (IoT) devices associated with each one of the parties in the marketplace;
determining, by the processing system, a utilization of one of the items by at least one of the parties or a requirement of one of the items by one of the parties by implementing the digital twin of the marketplace; and
facilitating, by the processing system, a transaction between at least one of the parties providing the at least one of the items and at least one of the parties having the utilization or the requirement of the at least one of the items based on the determination.

2. The method of claim 1, wherein the digital twin of the marketplace is generated based on information about:
the items in the marketplace including at least one of: current price of each of the items, price history of each of the items, order history of each of the items, or a service history of each of the items;
the parties in the marketplace including at least one of: transaction history of each of the parties, risk profile of each of the parties, social data of the each of the parties, or item portfolio of the each of the parties; and
the one or more IoT devices associated with each one of the parties in the marketplace include at least one of: a type of each of the one or more IoT devices or a capability of each of the one or more IoT devices.

3. The method of claim 2 further comprising:
placing, by the processing system, an order for a given item for a given party based on the determination; and
processing, by the processing system, an automated payment for the order using payment details of the given party.

4. The method of claim 2 further comprising:
forecasting, by the processing system, price of a given item in the marketplace for a defined time period by implementing the digital twin of the marketplace.

5. The method of claim 4 further comprising:
estimating, by the processing system, a lowest forecasted price of the given item in the defined time period based on the forecasting;
determining, by the processing system, a price difference between the lowest forecasted price of the given item and a current price of the given item; and
scheduling, by the processing system, an order for the given item for a time corresponding to the lowest forecasted price of the given item, if the price difference is above a defined price threshold.

6. The method of claim 5 further comprising:
defining, by the processing system, at least one of the time period or the price threshold based on an urgency of the requirement of the given item by implementing the digital twin of the marketplace.

7. The method of claim 2 further comprising:
determining, by the processing system, a current demand of a given item in the marketplace, by implementing the digital twin of the marketplace; and
adapting, by the processing system, a current price of the given item in the marketplace based on the current demand thereof.

8. The method of claim 1 further comprising:
determining, by the processing system, a forecasted demand of a given item in the marketplace, by implementing the digital twin of the marketplace; and
generating, by the processing system, an inventory forecast for one or more of the parties providing the given item based on the forecasted demand thereof.

9. The method of claim 1 further comprising:
determining, by the processing system, a forecasted demand of a given item in the marketplace, by implementing the digital twin of the marketplace; and
generating, by the processing system, a procurement order for the given item on behalf of one or more of the parties providing the given item to consumers to one or more of the parties manufacturing the given item, based on the forecasted demand thereof.

10. The method of claim 1, wherein the digital twin of the marketplace is a web of digital twins of the parties in the marketplace.

11. A computing system for automation of transactions in a transaction environment, the system comprising:
a processing system configured to:
generate a digital twin of a marketplace, wherein the digital twin is a digital representation of a structure of the marketplace, the structure being representative of a set of entities of the marketplace including items in the marketplace, parties in the marketplace, and one or more IoT devices associated with each one of the parties in the marketplace;
determine a utilization of one of the items by at least one of the parties or a requirement of one of the items by one of the parties by implementing the digital twin of the marketplace; and
facilitate a transaction between at least one of the parties providing the at least one of the items and at least one of the parties having the utilization or the requirement of the at least one of the items based on the determination.

12. The system of claim 11, wherein the processing system is configured to generate the digital twin of the marketplace based on information about:
the items in the marketplace including at least one of: current price of each of the items, price history of each of the items, order history of each of the items, or a service history of each of the items;
the parties in the marketplace including at least one of: transaction history of each of the parties, risk profile of each of the parties, social data of the each of the parties, or item portfolio of the each of the parties; and
the one or more IoT devices associated with each one of the parties in the marketplace include at least one of: a type of each of the one or more IoT devices or a capability of each of the one or more IoT devices.

13. The system of claim 12, wherein the processing system is further configured to:
place an order for a given item for a given party based on the determination; and
process an automated payment for the order using payment details of the given party.

14. The system of claim 12, wherein the processing system is further configured to:
forecast price of a given item in the marketplace for a defined time period by implementing the digital twin of the marketplace.

15. The system of claim 14, wherein the processing system is further configured to:
estimate a lowest forecasted price of the given item in the defined time period based on the forecasting;
determine a price difference between the lowest forecasted price of the given item and a current price of the given item; and
schedule an order for the given item for a time corresponding to the lowest forecasted price of the given item, if the price difference is above a defined price threshold.

16. The system of claim 15, wherein the processing system is further configured to:
define at least one of the time period and the price threshold based on an urgency of the requirement of the given item by implementing the digital twin of the marketplace.

17. The system of claim 12, wherein the processing system is further configured to:
determine a current demand of a given item in the marketplace, by implementing the digital twin of the marketplace; and
adapt a current price of the given item in the marketplace based on the current demand thereof.

18. The system of claim 11, wherein the processing system is further configured to:
determine a forecasted demand of a given item in the marketplace, by implementing the digital twin of the marketplace; and
generate an inventory forecast for one or more of the parties providing the given item based on the forecasted demand thereof.

19. The system of claim 11, wherein the processing system is further configured to:
determine a forecasted demand of a given item in the marketplace, by implementing the digital twin of the marketplace; and
generate a procurement order for the given item on behalf of one or more of the parties providing the given item to consumers to one or more of the parties manufacturing the given item, based on the forecasted demand thereof.

20. The system of claim 11, wherein the digital twin of the marketplace is a web of digital twins of the parties in the marketplace.

21. A computer-implemented method for automation of transactions in a transaction environment, the method comprising:
generating, by a processing system, a digital twin of the transaction environment, wherein the digital twin is a digital representation of a structure of the transaction environment, and wherein the structure having a set of entities and a set of relationships among the entities of the transaction environment;
determining, by the processing system, a utilization of the set of entities by implementing the digital twin of the transaction environment; and
facilitating, by the processing system, a transaction between at least one of the set of entities based on the determination.

22. The method of claim 21, wherein the set of entities includes items in the transaction environment, parties in the transaction environment, and one or more IoT devices associated with each one of the parties in the transaction environment;
wherein the utilization of the set of entities includes the utilization of one of the items by at least one of the parties or a requirement of one of the items by one of the parties by implementing the digital twin of the transaction environment; and
wherein the facilitating the transaction includes facilitating the transaction between at least one of the parties providing the at least one of the items and at least one of the parties having the utilization or the requirement of the at least one of the items.

23. The method of claim 21, wherein digital twin of the transaction environment is a representation that indicates at least one of: a type of entity, a transactor entity, a regulatory authority entity, or a regulatory relationship between entities.

24. A computer-implemented method for managing transactions in a transaction environment, the method comprising:
generating, by a processing system, a digital twin of a marketplace, wherein the digital twin is a digital representation of a structure of the marketplace, the structure having a set of entities of the marketplace including one or more of transactors in the marketplace, transaction authorities in the marketplace, lending authorities in the marketplace, and regulatory authorities in the marketplace;
generating, by the processing system, an artificial intelligence (AI) model trained on transactions data for the marketplace;
monitoring, by the AI model, the transactions, in near real-time, in the marketplace; and defining, by the processing system, a rules framework in the digital twin for executing transactions between each of the one or more of the transactors in the marketplace, the transaction authorities in the marketplace, the lending authorities in the marketplace, and the regulatory authorities in the marketplace based on the monitoring, by implementing the AI model.

25. The method of claim 24 further comprising:
implementing, by the processing system, the AI model in an edge computing arrangement associated with the marketplace, to enable the AI model to monitor the transactions, in near real-time, in the marketplace.

26. The method of claim 24 further comprising:
determining, by the processing system, at least one pattern in the transactions for each of the one or more transactors in the marketplace by implementing the AI model; and
generating, by the processing system, a risk profile for each of the one or more transactors in the marketplace based on the determined at least one pattern therefor.

27. The method of claim 26 further comprising:
executing, by the processing system, a given transaction between a given transactor and a given transaction authority based on the risk profile of the given transactor and the defined rules framework therebetween.

28. The method of claim 24 further comprising:
determining, by the processing system, at least one pattern in the transactions for each of the one or more transactors in the marketplace by implementing the AI model; and
generating, by the processing system, a lending profile for each of the one or more transactors in the marketplace based on the determined at least one pattern therefor.

29. The method of claim 28 further comprising:
executing, by the processing system, a given transaction between a given transactor and a given lending authority based on the lending profile of the given transactor and the defined rules framework therebetween.

30. The method of claim 24 further comprising:
determining, by the processing system, at least one pattern in the transactions for each of the one or more transactors in the marketplace by implementing the AI model; and
generating, by the processing system, a compliance profile for each of the one or more transactors in the marketplace based on the determined at least one pattern therefor.

31. The method of claim 30 further comprising:
executing, by the processing system, a given transaction between a given transactor and a given regulatory authority based on the compliance profile of the given transactor and the defined rules framework therebetween.

32. The method of claim 24 further comprising:
sharing, by the processing system, via a distributed leger, a profile of each of the one or more transactors with at least one of: the one or more transaction authorities in the marketplace, the one or more lending authorities in the marketplace, or the one or more regulatory authorities in the marketplace.

33. The method of claim 32 further comprising:
obtaining, by the processing system, a permission from each of the one or more transactors to share the corresponding profile with the at least one of: the one or more transaction authorities in the marketplace, the one or more lending authorities in the marketplace, or the one or more regulatory authorities in the marketplace.

34. The method of claim 33 further comprising:
masking, by the processing system, one or more defined personal details from the corresponding profile for each of the one or more transactors before sharing.

35. The method of claim 24 further comprising:
tokenizing, by the processing system, a given transaction in the marketplace; and
embedding, by the processing system, the tokenized given transaction in a given smart contract.

36. The method of claim 24 further comprising:
utilizing, by the processing system, a smart contract for automation of a given transaction based on instructions defined therein between any two of the one or more transactors in the marketplace, the one or more transaction authorities in the marketplace, the one or more lending authorities in the marketplace, or the one or more regulatory authorities in the marketplace by implementing the AI model.

37. The method of claim 24 further comprising:
implementing, by the processing system, the AI model to regulate one or more individual AI models associated with the one or more of the transaction authorities in the marketplace, the lending authorities in the marketplace, and the regulatory authorities in the marketplace.

38. The method of claim 24 further comprising:
allowing, by the processing system, for a human user to flag a given transaction of the monitored transactions;
training, by the processing system, the AI model based on the flagged given transaction; and
implementing, by the processing system, the AI model to flag one or more of the monitored transactions based on the training thereof.

39. The method of claim 24 further comprising:
analyzing, by the processing system, the monitored transactions to determine at least one of: a size, a structure, or a timing of issuing credit to a given transactor by a given lending authorities in the marketplace.

40. The method of claim 24 further comprising:
generating, by the processing system, a verifiable action token for the transactions in the marketplace.

41. The method of claim 24 further comprising:
defining, by the processing system, for the lending authorities, a credit line to be provided each of the transactors in the marketplace based on the transactions data and the monitoring of the transactions in the marketplace, by implementing the AI model.

42. A computing system for managing transactions in a transaction environment, the system comprising:
a processing system configured to:
generate a digital twin of a marketplace, wherein the digital twin is a digital representation of a structure of the marketplace, the structure having a set of entities of the marketplace including one or more of transactors in the marketplace, transaction authorities in the marketplace, lending authorities in the marketplace, and regulatory authorities in the marketplace;
generate an artificial intelligence (AI) model trained on transactions data for the marketplace;
monitor, by the AI model, the transactions, in near real-time, in the marketplace; and
define a rules framework in the digital twin for executing transactions between each of the one or more of the transactors in the marketplace, the transaction authorities in the marketplace, the lending authorities in the marketplace, and the regulatory authorities in the marketplace based on the monitoring, by implementing the AI model.

43. The system of claim 42 wherein the processing system is further configured to: implement the AI model in an edge computing arrangement associated with the marketplace, to enable the AI model to monitor the transactions, in near real-time, in the marketplace.

44. The system of claim 42 wherein the processing system is further configured to:
determine at least one pattern in the transactions for each of the transactors in the marketplace by implementing the AI model; and
generate a risk profile for each of the transactors in the marketplace based on the determined at least one pattern therefor.

45. The system of claim 44 wherein the processing system is further configured to:
execute a given transaction between a given transactor and a given transaction authority based on the risk profile of the given transactor and the defined rules framework therebetween.

46. The system of claim 42 wherein the processing system is further configured to:
determine at least one pattern in the transactions for each of the transactors in the marketplace by implementing the AI model; and
generate a lending profile for each of the transactors in the marketplace based on the determined at least one pattern therefor.

47. The system of claim 46 wherein the processing system is further configured to:
execute a given transaction between a given transactor and a given lending authority based on the lending profile of the given transactor and the defined rules framework therebetween.

48. The system of claim 42 wherein the processing system is further configured to:
determine at least one pattern in the transactions for each of the transactors in the marketplace by implementing the AI model; and
generate a compliance profile for each of the transactors in the marketplace based on the determined at least one pattern therefor.

49. The system of claim 48 wherein the processing system is further configured to:
execute a given transaction between a given transactor and a given regulatory authority based on the compliance profile of the given transactor and the defined rules framework therebetween.

50. The system of claim 42 wherein the processing system is further configured to:
share via a distributed leger, a profile of each of the one or more transactors with at least one of: the one or more transaction authorities in the marketplace, the one or more lending authorities in the marketplace, or the one or more regulatory authorities in the marketplace.

51. The system of claim 50 wherein the processing system is further configured to:
obtain a permission from each of the one or more transactors to share the corresponding profile with the at least one of: the one or more transaction authorities in the marketplace, the one or more lending authorities in the marketplace, or the one or more regulatory authorities in the marketplace.

52. The system of claim 51 wherein the processing system is further configured to:
mask one or more defined personal details from the corresponding profile for each of the transactors before sharing.

53. The system of claim 42 wherein the processing system is further configured to:
tokenize a given transaction in the marketplace; and
embed the tokenized given transaction in a given smart contract.

54. The system of claim 42 wherein the processing system is further configured to:
utilize a smart contract for automation of a given transaction based on instructions defined therein between any two of the one or more transactors in the marketplace, the one or more transaction authorities in the marketplace, the one or more lending authorities in the marketplace, or the one or more regulatory authorities in the marketplace by implementing the AI model.

55. The system of claim 42 wherein the processing system is further configured to:
implement the AI model to regulate one or more individual AI models associated with the one or more of the transaction authorities in the marketplace, the lending authorities in the marketplace, or the regulatory authorities in the marketplace.

56. The system of claim 42 wherein the processing system is further configured to:
allow for a human user to flag a given transaction of the monitored transactions;
train the AI model based on the flagged given transaction; and
implement the AI model to flag one or more of the monitored transactions based on the training thereof.

57. The system of claim 42 wherein the processing system is further configured to:
analyze the monitored transactions to determine at least one of: a size, a structure, or a timing of issuing credit to a given transactor by a given lending authorities in the marketplace.

58. The system of claim 42 wherein the processing system is further configured to:
generate a verifiable action token for the transactions in the marketplace.

59. The system of claim 42 wherein the processing system is further configured to:
define for the lending authorities, a credit line to be provided each of the transactors in the marketplace based on the transactions data and the monitoring of the transactions in the marketplace, by implementing the AI model.

60. A computer-implemented method for managing transactions in a transaction environment, the method comprising:
generating, by a processing system, a digital twin of the transaction environment, wherein the digital twin is a digital representation of a structure of the transaction environment, and wherein the structure having a set of entities and a set of relationships among the entities of the transaction environment;
generating, by the processing system, an artificial intelligence (AI) model trained on transactions data for the transaction environment;
monitoring, by the AI model, the transactions, in near real-time, in the transaction environment; and
defining, by the processing system, a rules framework in the digital twin for executing transactions in the transaction environment based on the monitoring by implementing the AI model.

61. The method of claim 60 wherein the set of entities includes one or more of parties in the transaction environment, transaction authorities in the transaction environment, lending authorities in the transaction environment, or regulatory authorities in the transaction environment; and wherein the defining of the rules framework includes defining of the rules framework in the digital twin for executing transactions between each of the at least one or more of the parties in the transaction environment, the transaction authorities in the transaction environment, the lending authorities in the transaction environment, or the regulatory authorities in the transaction environment based on the monitoring, by implementing the AI model.

62. The method of claim 24, wherein the digital representation indicates at least one of: a type of entity, a transactor entity, a regulatory authority entity, or a regulatory relationship between entities.

63. A computer-implemented method for automating processing of transactions in a transaction environment, the method comprising:
generating, by a processing system, an artificial intelligence (AI) model trained on a set of user interactions related to one or more transactions in response to corresponding one or more events in a marketplace;
configuring, by the processing system, a robotic process automation (RPA) module to mimic the user interactions by implementing the AI model;
monitoring, by the processing system, in near real-time, events in the marketplace; and implementing, by the processing system, the RPA module to automatically process a transaction in response to a given event in the marketplace, as per the monitoring, by providing corresponding instructions complementary to one or more user interactions otherwise required therefor.

64. The method of claim 63 further comprising:
implementing, by the processing system, the RPA module to generate an invoice, for a given party delivering one or more items to a party receiving the one or more items, for a given event of completion of delivery of the one or more items.

65. The method of claim 63 further comprising:
implementing, by the processing system, the RPA module to process a registration of a person for a given event of completion of a predefined age for the person.

66. The method of claim 63 further comprising:
implementing, by the processing system, the RPA module to process a trade for at least one of: buying, selling, or shorting a security from a security exchange in the marketplace for a given event of a trigger price.

67. The method of claim 63 further comprising:
implementing, by the processing system, the RPA module to process a purchase of an insurance for a trade to be executed from an insurance exchange in the marketplace for a given event of price volatility.

68. The method of claim 63 further comprising:
implementing, by the processing system, the RPA module to trigger an insurance claim for an event of an accident.

69. A computing system for automating processing of transactions in a transaction environment, the system comprising:
a processing system configured to:
generate an artificial intelligence (AI) model trained on a set of user interactions related to one or more transactions in response to corresponding one or more events in a marketplace;
configure a robotic process automation (RPA) module to mimic the user interactions by implementing the AI model;
monitor in near real-time, events in the marketplace; and
implement the RPA module to automatically process a transaction in response to a given event in the marketplace, as per the monitoring, by providing corresponding instructions complementary to one or more user interactions otherwise required therefor.

70. The system of claim 69, wherein the processing system is further configured to:
implement the RPA module to generate an invoice, for a given party delivering one or more items to a party receiving the one or more items, for a given event of completion of delivery of the one or more items.

71. The system of claim 69, wherein the processing system is further configured to:
implement the RPA module to process a registration of a person for a given event of completion of a predefined age for the person.

72. The system of claim 69, wherein the processing system is further configured to:
implement the RPA module to process a trade for at least one of: buying, selling, or shorting a security from a security exchange in the marketplace for a given event of a trigger price.

73. The system of claim 69, wherein the processing system is further configured to:
implement the RPA module to process a purchase of an insurance for a trade to be executed from an insurance exchange in the marketplace for a given event of price volatility.

74. The system of claim 69, wherein the processing system is further configured to:
implement the RPA module to trigger an insurance claim for an event of an accident.

75. A computing system for automating processing of transactions in a transaction environment, the system comprising:
a processing system configured to:
generate an artificial intelligence (AI) model trained based on one or more transactions in response to corresponding one or more events in a marketplace;
configure a robotic process automation (RPA) module by implementing the AI model;
monitor in near real-time, events in the marketplace; and
implement the RPA module to automatically process a transaction in response to a given event in the marketplace, as per the monitoring, by providing corresponding instructions based on one or more recommendations.

76. A computer-implemented method for automated orchestration of a transaction environment, the method comprising:
obtaining, by a processing system, information about different items in a marketplace, including information about at least one attribute associated with each of the different items;
aggregating, by the processing system, one or more items in the marketplace into corresponding one or more aggregate assets based, at least in part, on the respective at least one attribute associated therewith;
generating, by the processing system, a digital twin representing the marketplace with the one or more aggregate assets; and
facilitating, by the processing system, one or more transactions for each one of the one or more aggregate assets independent of another one or more aggregate assets in the marketplace.

77. The method of claim 76 further comprising providing, by the processing system, a set of interface elements for a party to access at least one of the one or more aggregate assets therein independent of the other one or more aggregate assets.

78. The method of claim 76 further comprising:
recording, by the processing system, user interactions related to assigning of corresponding values, as the at least one attribute, to the different items in the marketplace and to
aggregating of the different items as the one or more aggregate assets in the marketplace in relation to the assigned values thereto;
configuring, by the processing system, a robotic process automation (RPA) module to mimic the user interactions related to the assigning of corresponding values to the different items and the aggregating of the different items into the one or more aggregate assets; and
implementing, by the processing system, the RPA module to automatically assign value to a given item in the marketplace and to automatically aggregate one or more given items into one or more aggregate assets based on the automatically assigned values thereto in the marketplace.

79. The method of claim 76 further comprising:
recording, by the processing system, user interactions related to translation of values, as one of the one or more transactions, of the one or more aggregate assets from one of exchanges in the marketplace to another one of the exchanges in the marketplace;
configuring, by the processing system, a robotic process automation (RPA) module to mimic the user interactions related to the translation of values of the one or more aggregate assets; and
implementing, by the processing system, the RPA module to automatically translate a first value of a given aggregated asset represented in a first exchange into a second value of the given aggregated asset for representation in a second exchange.

80. The method of claim 76 further comprising:
recording, by the processing system, user interactions related to generation of a token, as one of the one or more transactions, for the one or more aggregate assets as represented in one of exchanges in the marketplace to be transferred to be representation in another one of the exchanges in the marketplace;
configuring, by the processing system, a robotic process automation (RPA) module to mimic the user interactions related to the generation of the token for the one or more aggregate assets; and
implementing, by the processing system, the RPA module to automatically generate a token for a given aggregated asset represented in a first exchange to transfer the given aggregated asset for representation in a second exchange.

81. The method of claim 76 further comprising:
recording, by the processing system, user interactions related to generation of digital representations of a set of rights, as one of the one or more transactions, for the one or more aggregate assets in the marketplace based on at least one of a set of smart contracts and a set of terms and conditions related to the different aggregate assets;
configuring, by the processing system, a robotic process automation (RPA) module to mimic the user interactions related to the generation of digital representations of a set of rights for the one or more aggregate assets; and
implementing, by the processing system, the RPA module to automatically generate a digital representation of a set of rights for a given aggregate asset in the marketplace based on at least one of the set of smart contracts and the set of terms and conditions related thereto.

82. The method of claim 76 further comprising:
recording, by the processing system, user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace;
configuring, by the processing system, a robotic process automation (RPA) module to mimic the user interactions related to the orchestrating a set of transaction workflows for the one or more aggregate assets; and
implementing, by the processing system, the RPA module to automatically orchestrate a set of transaction workflows for a given aggregated asset by initiating a set of first actions in the at least one of the exchanges in response to triggering of a set of second actions in the at least one other exchange in the marketplace.

83. The method of claim 76 further comprising:
recording, by the processing system, user interactions related to adjusting of timing of delivery, as one of the one or more transactions, for the one or more aggregate assets based on at least one of a transaction parameter or a network performance parameter in the marketplace;
configuring, by the processing system, a robotic process automation (RPA) module to mimic the user interactions related to the adjusting of timing of delivery for the one or more aggregate assets; and
implementing, by the processing system, the RPA module to automatically adjust timing of delivery for a given aggregated asset based on at least one of the transaction parameter or the network performance parameter in the marketplace.

84. The method of claim 76 further comprising:
recording, by the processing system, user interactions related to determining of demand, as the at least one attribute, for the different items in the marketplace and to aggregating of the different items as the one or more aggregate assets in the marketplace in relation to the demand thereof;
configuring, by the processing system, a robotic process automation (RPA) module to mimic the user interactions related to the determining of demand for the different items and the aggregating of the different items into the one or more aggregate assets; and
implementing, by the processing system, the RPA module to automatically determine demand for a given item in the marketplace and to automatically aggregate one or more given items into one or more aggregate assets based on the automatically determined demands thereof in the marketplace.

85. The method of claim 76 further comprising:
recording, by the processing system, user interactions related to curation of a set of micro-transactions for the one or more aggregate assets and processing of the curated set of micro-transactions as a single transaction for the one or more aggregate assets, as one of the one or more transactions, in the marketplace;
configuring, by the processing system, a robotic process automation (RPA) module to mimic the user interactions related to the curation of the set of micro-transactions for the one or more aggregate assets and processing of the curated set of micro-transactions as the single transaction for the one or more aggregate assets; and
implementing, by the processing system, the RPA module to automatically curate a set of micro-transactions for a given aggregated asset and process the automatically curated set of micro-transactions as a single transaction in the marketplace.

86. A system for automated orchestration of a transaction environment, the system comprising:
a processing system configured to:
obtain information about different items in a marketplace, including information about at least one attribute associated with each of the different items;
aggregate one or more items in the marketplace into corresponding one or more aggregate assets based, at least in part, on the respective at least one attribute associated therewith;
generate a digital twin representing the marketplace with the one or more aggregate assets; and
facilitate one or more transactions for each one of the one or more aggregate assets independent of another one or more aggregate assets in the marketplace.

87. The system of claim 86, wherein the processing system is further configured to provide a set of interface elements for a party to access at least one of the one or more aggregate assets therein independent of the other one or more aggregate assets.

88. The system of claim 86, wherein the processing system is further configured to:
record user interactions related to assigning of corresponding values, as the at least one attribute, to the different items in the marketplace and to aggregating of the different items as the one or more aggregate assets in the marketplace in relation to the assigned values thereto;
configure a robotic process automation (RPA) module to mimic the user interactions related to the assigning of corresponding values to the different items and the aggregating of the different items into the one or more aggregate assets; and
implement the RPA module to automatically assign value to a given item in the marketplace and to automatically aggregate one or more given items into one or more aggregate assets based on the automatically assigned values thereto in the marketplace.

89. The system of claim 86, wherein the processing system is further configured to:
record user interactions related to translation of values, as one of the one or more transactions, of the one or more aggregate assets from one of exchanges in the marketplace to another one of the exchanges in the marketplace;
configure a robotic process automation (RPA) module to mimic the user interactions related to the translation of values of the one or more aggregate assets; and
implement the RPA module to automatically translate a first value of a given aggregated asset represented in a first exchange into a second value of the given aggregated asset for representation in a second exchange.

90. The system of claim 86, wherein the processing system is further configured to:
record user interactions related to generation of a token, as one of the one or more transactions, for the one or more aggregate assets as represented in one of exchanges in the marketplace to be transferred to be representation in another one of the exchanges in the marketplace;
configure a robotic process automation (RPA) module to mimic the user interactions related to the generation of the token for the one or more aggregate assets; and
implement the RPA module to automatically generate a token for a given aggregated asset represented in a first exchange to transfer the given aggregated asset for representation in a second exchange.

91. The system of claim 86, wherein the processing system is further configured to:
record user interactions related to generation of digital representations of a set of rights, as one of the one or more transactions, for the one or more aggregate assets in the marketplace based on at least one of a set of smart contracts and a set of terms and conditions related to the different aggregate assets;
configure a robotic process automation (RPA) module to mimic the user interactions related to the generation of digital representations of a set of rights for the one or more aggregate assets; and
implement the RPA module to automatically generate a digital representation of a set of rights for a given aggregate asset in the marketplace based on at least one of the set of smart contracts and the set of terms and conditions related thereto.

92. The system of claim 86, wherein the processing system is further configured to:
record user interactions related to orchestrating a set of transaction workflows, as one of the one or more transactions, for the one or more aggregate assets involving initiation of a set of first actions in at least one of the exchanges in response to triggering of a set of second actions in at least one other exchange in the marketplace;
configure a robotic process automation (RPA) module to mimic the user interactions related to the orchestrating a set of transaction workflows for the one or more aggregate assets; and
implement the RPA module to automatically orchestrate a set of transaction workflows for a given aggregated asset by initiating a set of first actions in the at least one of the exchanges in response to triggering of a set of second actions in the at least one other exchange in the marketplace.

93. The system of claim 86, wherein the processing system is further configured to:
record user interactions related to adjusting of timing of delivery, as one of the one or more transactions, for the one or more aggregate assets based on at least one of a transaction parameter or a network performance parameter in the marketplace;
configure a robotic process automation (RPA) module to mimic the user interactions related to the adjusting of timing of delivery for the one or more aggregate assets; and
implement the RPA module to automatically adjust timing of delivery for a given aggregated asset based on at least one of the transaction parameter or the network performance parameter in the marketplace.

94. The system of claim 86, wherein the processing system is further configured to:
record user interactions related to determining of demand, as the at least one attribute, for the different items in the marketplace and to aggregating of the different items as the one or more aggregate assets in the marketplace in relation to the demand thereof;
configure a robotic process automation (RPA) module to mimic the user interactions related to the determining of demand for the different items and the aggregating of the different items into the one or more aggregate assets; and
implement the RPA module to automatically determine demand for a given item in the marketplace and to automatically aggregate one or more given items into one or more aggregate assets based on the automatically determined demands thereof in the marketplace.

95. The system of claim 86, wherein the processing system is further configured to:
record user interactions related to curation of a set of micro-transactions for the one or more aggregate assets and processing of the curated set of micro-transactions as a single transaction for the one or more aggregate assets, as one of the one or more transactions, in the marketplace;
configure a robotic process automation (RPA) module to mimic the user interactions related to the curation of the set of micro-transactions for the one or more aggregate assets and processing of the curated set of micro-transactions as the single transaction for the one or more aggregate assets; and
implement the RPA module to automatically curate a set of micro-transactions for a given aggregated asset and process the automatically curated set of micro-transactions as a single transaction in the marketplace.

96. A computer-implemented method for augmenting of services in a transaction environment, the method comprising:
generating, by a processing system, a digital twin of a marketplace, wherein the digital twin is a digital representation of a set of parties in the marketplace and a set of services available in the marketplace;
monitoring, by the processing system, service transactions between the set of parties in the marketplace;
analyzing, by the processing system, a nature of a current service transaction by a given party of the set of parties in the marketplace based on the monitoring;
determining, by the processing system, by implementing the digital twin, a supplementary service from the set of services related to the current service transaction suitable for the given party based on the nature of the current service transaction; and
providing, by the processing system, a recommendation for the supplementary service to the given party.

97. The method of claim 96 further comprising:
generating, by the processing system, an artificial intelligence (AI) model trained on information about relationship between different services of the set of services available in the marketplace; and
implementing, by the processing system, the AI model to determine the supplementary service from the set of services related to the current service transaction suitable for the given party.

98. The method of claim 96, wherein the supplementary service comprises at least one of: a guarantee service, an insurance service, a loan service, a discount service, a promotion service, a verification service, a validation service, a sponsorship service, a rewards service, a tax service, a fraud alert service, or a compliance service.

99. The method of claim 96, wherein the supplementary service is a value-added service.

100. The method of claim 96, wherein the one of the parties in the set of parties in the marketplace is a consumer comprising at least one of: a person, an enterprise, a machine, a real estate, a manufacturer, or an asset owner.

101. The method of claim 96, wherein the one of the parties in the set of parties in the marketplace is a service provider comprising at least one of: a merchant, a payments provider, a guarantor, an identity manager, an insurer, a banker, a lender, a host, or a presenter.

102. The method of claim 101, wherein the provided set of services in the marketplace is configurable by the service provider.

103. The method of claim 96, wherein analyzing the nature of the current service transaction comprises estimating interconnectedness of other transaction services related to the current service transaction, and wherein the supplementary service is determined based on the estimated interconnectedness of other transaction services.

104. The method of claim 96, wherein analyzing the nature of the current service transaction comprises estimating likeness of other transaction services, related to the current service transaction, by other parties of the set of parties in the marketplace, and wherein the supplementary service is determined based on the estimated likeness of other transaction services.

105. The method of claim 96, wherein the marketplace is a virtual environment.

106. A system for augmenting of services in a transaction environment, the system comprising:
a processing system configured to:
generate a digital twin of a marketplace, wherein the digital twin is a digital representation of a set of parties in the marketplace and a set of services available in the marketplace;
monitor service transactions between the set of parties in the marketplace;
analyze a nature of a current service transaction by a given party of the set of parties in the marketplace based on the monitoring;
determine, by implementing the digital twin, a supplementary service from the set of services related to the current service transaction suitable for the given party based on the nature of the current service transaction; and
provide a recommendation for the supplementary service to the given party.

107. The system of claim 106, wherein the processing system is further configured to:
generate an artificial intelligence (AI) model trained on information about relationship between different services of the set of services available in the marketplace; and
implement the AI model to determine the supplementary service from the set of services related to the current service transaction suitable for the given party.

108. The system of claim 106, wherein the supplementary service comprises at least one of: a guarantee service, an insurance service, a loan service, a discount service, a promotion service, a verification service, a validation service, a sponsorship service, a rewards service, a tax service, a fraud alert service, or a compliance service.

109. The system of claim 106, wherein the supplementary service is a value-added service.

110. The system of claim 106, wherein the one of the parties in the set of parties in the marketplace is a consumer comprising at least one of: a person, an enterprise, a machine, a real estate, a manufacturer, or an asset owner.

111. The system of claim 106, wherein the one of the parties in the set of parties in the marketplace is a service provider comprising at least one of: a merchant, a payments provider, a guarantor, an identity manager, an insurer, a banker, a lender, a host, or a presenter.

112. The system of claim 111, wherein the provided set of services in the marketplace is configurable by the service provider.

113. The system of claim 106, wherein analyzing the nature of the current service transaction comprises estimating interconnectedness of other transaction services related to the current service transaction, and wherein the supplementary service is determined based on the estimated interconnectedness of other transaction services.

114. The system of claim 106, wherein analyzing the nature of the current service transaction comprises estimating likeness of other transaction services, related to the current service transaction, by other parties of the set of parties in the marketplace, and wherein the supplementary service is determined based on the estimated likeness of other transaction services.

115. The system of claim 106, wherein the marketplace is a virtual environment.
